(19) United States
(12) Patent Application Publication
(10) Pub. No.: US 2026/0068886 A1
(43) Pub. Date: Mar. 12, 2026

(54) COMPOSITIONS AND METHODS FOR TARGETED INHIBITION AND DEGRADATION OF PROTEINS IN AN INSECT CELL

(71) Applicant: Oerth Bio LLC, Durham, NC (US)

(72) Inventors: Jason D. Speake, Mebane, NC (US); Christopher C. Ladner, Raleigh, NC (US); Hamilton D. Dickson, Cary, NC (US); John G. Catalano, Durham, NC (US); Kelly D. D. Broccio, Cary, NC (US); Melina M. R. Lillich, Durham, NC (US); Samuel G. Gattis, Durham, NC (US); Steven C. Bremmer, Apex, NC (US)

(73) Assignee: Oerth Bio LLC, Durham, NC (US)

(21) Appl. No.: 19/106,854

(22) PCT Filed: Aug. 31, 2023
(86) PCT No.: PCT/US2023/031716

§ 371 Date: Feb. 26, 2025

Related U.S. Application Data
(60) Provisional application No. 63/402,687, filed on Aug. 31, 2022.
(60) Provisional application No. 63/530,395, filed on Aug. 2, 2023.

(51) Int. Cl. A01N 43/90; A01N 43/78; A01N 43/80; A01N 53/00; A01P 7/04

(52) U.S. Cl. CPC A01N 43/90; A01N 43/78; A01N 43/80; A01N 53/00; A01P 7/04

(57) ABSTRACT

Provided herein are compositions, compounds, and methods for modulating the levels of target proteins in insects and insect cells. The compounds may contain one or more protein targeting moieties that each independently bind a protein that is expressed by an insect cell; one or more ligase targeting moieties that each independently bind a ubiquitin ligase that is functional in the insect cell; and a linker covalently bonded to the one or more protein targeting moieties and the one or more ligase targeting moieties; or a salt or a solvate thereof.

### CROSS-REFERENCES TO RELATED APPLICATIONS

The present application claims priority to U.S. Provisional Application No. 63/402,687, filed Aug. 31, 2022, and U.S. Provisional Application No. 63/530,395, filed Aug. 2, 2023, the full disclosures of which are incorporated by reference in their entirety for all purposes.

### FIELD

This disclosure describes compositions, compounds, and methods for modulating the levels of target proteins in insects and insect cells. In particular, this disclosure describes compositions comprising one or more protein targeting moieties, one or more ligase targeting moieties, and a linker covalently bonded to the one or more protein targeting moieties and the one or more ligase targeting moieties, as well as methods for the use of such compositions.

### BACKGROUND

Insect pests continue to be a major cause of crop losses. In the US alone, billions of dollars are lost every year due to infestation by various genera of insects. In addition to losses in field crops, insect pests also cause burdens to vegetable and fruit growers and producers of ornamental flowers, making insects a general nuisance to gardeners and homeowners. Numerous commercially valuable plants, including common agricultural crops, are susceptible to attack by plant pests including insect and nematode pests, causing significant reductions in crop yield and quality.

Compositions for controlling insect infestations in plants have typically been in the form of chemical insecticides. However, there are several disadvantages to using chemical insecticides. For example, chemical insecticides are generally not selective. Additionally, applications of chemical insecticides intended to control insect pests in crop plants can exert their effects on non-target insects (including pollinators) and other invertebrates. Chemical insecticides often persist in the environment and may be slow to degrade, thus potentially accumulating in the food chain. Furthermore, the use of persistent chemical insecticides can result in the development of resistance in the target insect species.

Biological pest control agents, such as Bacillus thuringiensis strains expressing pesticidal polypeptides, have been applied to crop plants with satisfactory results, thus offering an alternative or complement to chemical pesticides. The expression of Cry proteins in transgenic plants has provided efficient protection against certain insect pests, and transgenic plants expressing such proteins have been commercialized, allowing farmers to reduce or eliminate applications of chemical insect control agents.

Although the usage of transgenic plants expressing Cry proteins has been shown to be extremely effective, insect pests have developed resistance against the Cry proteins expressed in certain transgenic plants. Therefore, there remains a need to identify new and effective pest control agents. Particularly, control agents that are targeted to a wider spectrum of economically important insect pests and that have a high specific activity against insect pests that are or could become resistant to existing insect control agents are needed. Thus, there has been a long-felt need for more environmentally friendly methods for controlling or eradicating insect infestation on or in plants, e. g., methods which are environmentally inert, non-persistent, biodegradable, and that fit well into pest resistance management schemes.

### BRIEF SUMMARY

The terms “invention,” “the invention,” “this invention,” and “the present invention,” as used in this document, are intended to refer broadly to all of the subject matter of this patent application and the claims below. Statements containing these terms should be understood not to limit the subject matter described herein or to limit the meaning or scope of the patent claims below. Covered embodiments of the invention are defined by the claims, not this summary. This summary is a high-level overview of various aspects of the invention and introduces some of the concepts that are described and illustrated in the present document and the accompanying figures. This summary is not intended to identify key or essential features of the claimed subject matter, nor is it intended to be used in isolation to determine the scope of the claimed subject matter. The subject matter should be understood by reference to appropriate portions of the entire specification, any or all figures, and each claim. Some of the exemplary embodiments of the present invention are discussed below.

Provided herein are compounds, compositions, and methods for the targeted inhibition and degradation of proteins in insects and insect cells. Compounds include bifunctional compounds that target an insect protein of interest to a cellular pathway. In some instances, the pathway leads to degradation or inhibition of the insect protein. The bifunctional compounds can be selected from proteolysis targeting chimeras (PROTACs), molecular glues, phosphatase recruiting chimeras (PhoRCs), deubiquitinase-targeting chimeras (DUBTAC), ribonuclease targeting chimeras (RIBOTACs), autophagy-targeting chimeras (AUTACs), autophagosome-tethering compounds (ATTECs), lysosome-targeting chimeras (LYTACs), and Chaperone-mediated Protein Degradation/Degrader (CHAMP) molecules.

In some embodiments, the methods utilize Proteolysis Targeting Chimeras (PROTACs) to direct degradation or inhibition of a protein of interest in an insect. PROTACs are a class of bifunctional molecules that utilize the endogenous protein homeostasis machinery to degrade a protein of interest (POI). PROTACs of the invention induce proximity between an insect ligase and a POI by forming a ternary complex that results in the ubiquitination and subsequent degradation of the POI by the proteasome. Accordingly, the PROTAC bifunctional compounds comprise a binding ligand for a ubiquitin ligase and a second binding ligand for a protein of interest (POI), the target protein, to mediate ubiquitin transfer to, and degradation of, the protein of interest through the proteasome. The first binding ligand is also referred to as a ligase targeting moiety (LTM) while the second binding ligand is referred to as a protein targeting moiety (PTM). It is recognized that when using the term moiety, the moiety itself, a derivative of the moiety, or an analog of the moiety are intended and can be used in the practice of the disclosed methods. Furthermore, the compounds disclosed herein include enantiomers, diastereomers, stereoisomers or agriculturally acceptable salts thereof.

The provided compounds, compositions, and methods are advantageous as smaller amounts of the PROTAC compositions are needed for administration to control insects. In some embodiments, the bifunctional compounds provided herein can include more than one ligase binding moiety, more than one insect protein targeting moiety, and more than one linker.

The bifunctional compounds of the invention can be provided in compositions comprising suitable agricultural carriers for delivery directly to the insect pests, and to the locus of the insect pests, including plants, surfaces, and areas where they are ready for contact by insects. Compositions may further include insects, insect cells, plants, plant cells, plant parts and treated surfaces comprising the bifunctional compounds provided herein.

In one aspect, the disclosure is to a compound or a salt or a solvate thereof. The compound includes one or more protein targeting moieties that each independently bind a protein that is expressed by an insect cell. The compound further includes one or more ligase targeting moieties that each independently bind a ubiquitin ligase that is functional in the insect cell. The compound further includes a linker covalently bonded to the one or more protein targeting moieties and the one or more ligase targeting moieties.

In another aspect, the disclosure is to a composition including a compound as disclosed herein, or a salt or solvate thereof. In some embodiments, the composition further includes an agriculturally acceptable carrier.

In another aspect, the disclosure is to a method of controlling a level of a target protein in an insect cell. The method includes contacting the insect cell with an effective amount of a compound as disclosed herein, or with an effective amount of a composition as disclosed herein.

### BRIEF DESCRIPTION OF THE DRAWINGS

FIG. 1 presents a table and an image of a gel showing that FKBP substrate is ubiquitinated in vitro through sfVHL mediated by dTAGV-1 PROTAC in presence of E1 & E2. Lanes 1-4 and 5-8 are replicates of dose dependent dTAGV-1 dependent ubiquitination of MBP-FKBP-HIbit by sfVHL in vitro. In vitro ubiquitination is sfVHL dependent. No ubiquitination of MBP-FKBP-Hibit is observed in the absence of sfVHL (Lanes 9-16).

FIG. 2 presents graphs showing the FKBP-GFP to RFP signal ratio when treated with dTAG-V1 (dose curve) and Bortezomib (1 or 10 μM).

FIG. 3 presents microscopy images showing the data plotted in the graphs of FIG. 2. The images are of dTAG-V1 treated Sf9 cells expressing FKBP-GFP-P2A-RFP observed in Brightfield, green fluorescent protein and red fluorescent protein excitation wavelengths.

### DETAILED DESCRIPTION

Compounds, compositions, and methods for inhibiting and modulating protein levels in an insect are provided. In some embodiments, the bifunctional compounds are PROTACs, and methods comprise their use in targeting and modulating the levels of proteins of interest (POI) in an insect cell. The PROTAC compositions function to recruit endogenous proteins to an insect ubiquitin ligase enzyme for ubiquitination and subsequent degradation or inhibition. The compounds may be designed to target any protein of interest present in an insect cell. The compounds may be provided in agricultural compositions.

Other classes of heterobifunctional molecules provided herein depend on non-UPS pathways to degrade a protein of interest (POI). These classes include autophagy-targeting chimeras (AUTACs), autophagosome-tethering compounds (ATTECs), lysosome-targeting chimeras (LYTACs), molecular glues, and antibody-based PROTACs (AbTACs). Collectively, AUTACs and ATTECs are also macroautophagy degradation-targeting chimeras (MADTACs). Like PROTACs, AUTECs and ATTECs focus on intracellular triggering of targeted protein degradation, while LYTACs and AbTACs trigger intercellular degradation via an extracellular process. AUTACs link a warhead for the POI to a guanine derivative that tags the protein for degradation by the autophagy machinery. ATTECs link a POI warhead to a ligand that binds to the autophagy protein LC3 (microtubule-associated protein 1 light chain 3α) glue, thereby bypassing the ubiquitin pathways by directly tethering the POI to the autophagosome. LYTACs bind a membrane-bound POI and the extracellular domains of a lysosome-shuttling receptor, which then drags the POI into the lysosome for degradation. AbTACs are bispecific antibodies that recruit membrane bound E3 ligases to a membrane POI for degradation by the lysosome degradation pathway. Molecular glues are small molecules that act as adhesives by making two proteins bind each other. Molecular glues engage the E3 ligase allowing that complex to recruit its target. CHAMPs are bifunctional molecules similar to PROTACs. CHAMPs recruit the POI via a chaperone protein complex, leading to the ubiquitination of the POI and then the degradation of the POI via the proteasome system. Chaperones can interact with a diverse collection of E3 ligases. Importantly, the key chaperone HSP90 (enabling the use of CHAMPs for human therapeutics) is highly conserved in insects: e.g., 81% (bitscore of 1,131) between humans and fall armyworm (Spodoptera frugiperda) with 14 out of 15 key amino acid residues perfectly identical in the binding site being used to bind to HSP90.

Presently described are compositions and methods that relate to the surprising and unexpected discovery that levels of target proteins expressed in an insect cell may be controlled with compounds comprising one or more protein targeting moieties (PTM) that each independently bind a target protein, one or more ligase targeting moieties (LTM) that each independently bind a ubiquitin ligase that is functional in an insect cell and a linker covalently bonded to the one or more protein targeting moieties and the one or more ligase targeting moieties. An E3 ubiquitin ligase protein (e.g., Von Hippel-Lindau E3 ubiquitin ligase (VHL) or Cereblon (CRBN)) ubiquitinates a target protein once it and the target protein are placed in proximity by a bifunctional or chimeric construct that binds the E3 ubiquitin ligase protein and the target protein. Accordingly, the present disclosure provides such compounds and compositions comprising an E3 ubiquitin ligase binding moiety coupled to a protein target binding moiety, which result in the ubiquitination of a chosen target protein and leads to degradation of the target protein by the proteasome.

In certain aspects, the present disclosure provides compounds that comprise a ligand, e.g., a small molecule ligand (i.e., having a molecular weight of below 2,000 Daltons, 1,000 Daltons, 500 Daltons, or 200 Daltons) that is capable of binding to a ubiquitin ligase, such as VHL or CRBN. The compounds also comprise a moiety that is capable of binding to target protein in such a way that the target protein is placed in proximity to the ubiquitin ligase to effect degradation (and/or inhibition) of that protein.

### A. Definitions

The abbreviations used herein have their conventional meaning within the chemical and biological arts. Description of compounds of the present disclosure are limited by principles of chemical bonding known to those skilled in the art. Accordingly, where a group may be substituted by one or more of a number of substituents, such substitutions are selected so as to comply with principles of chemical bonding and to give compounds which are not inherently unstable and/or would be known to one of ordinary skill in the art as likely to be unstable under ambient conditions, such as aqueous, neutral, or physiological conditions. Where substituent groups are specified by their conventional chemical formulae, written from left to right, they equally encompass the chemically identical substituents that would result from writing the structure from right to left, e.g., —CH₂O— is equivalent to —OCH₂—.

As used herein, the singular forms “a,” “an,” and “the” include plural referents unless the content clearly dictates otherwise. Thus, for example, reference to “a polymer” optionally includes a combination of two or more polymers, and the like.

As used herein, the term “and/or” refers to and encompasses any and all possible combinations of one or more of the associated listed items, as well as the lack of combinations when interpreted in the alternative (“or”).

The term “about” as used herein refers to the usual error range for the respective value readily known to the skilled person in this technical field, for example ±20%, +10%, or 5%, are within the intended meaning of the recited value.

As used herein, the terms “including,” “comprising,” “having,” “containing,” and variations thereof, are inclusive and open-ended and do not exclude additional, unrecited elements or method steps beyond those explicitly recited. As used herein, the phrase “consisting of” is closed and excludes any element, step, or ingredient not explicitly specified. As used herein, the phrase “consisting essentially of” limits the scope of the described feature to the specified materials or steps and those that do not materially affect the basic and novel characteristics of the disclosed feature.

As used herein, the term “alkyl,” by itself or as part of another substituent, refers to a straight or branched, saturated, aliphatic radical having the number of carbon atoms indicated. A branched alkyl may include one or branches having a geminal, vicinal, and/or isolated pattern.

For example, an alkyl may include gem-methyl groups. Alkyl may include any number of carbons, such as C₁₋₂, C₁₋₃, C₁₋₄, C₁₋₅, C₁₋₆, C₁₋₇, C₁₋₈, C₁₋₉, C₁₋₁₀, C₂₋₃, C₂₋₄, C₂₋₅, C₂₋₆, C₃₋₄, C₃₋₅, C₃₋₆, C₄₋₅, C₄₋₆ and C₅₋₆. For example, C₁₋₆ alkyl includes, but is not limited to, methyl, ethyl, propyl, isopropyl, butyl, isobutyl, sec-butyl, tert-butyl, pentyl, isopentyl, hexyl, etc. Alkyl may also refer to alkyl groups having up to 20 carbons atoms, such as, but not limited to heptyl, octyl, nonyl, decyl, etc. Alkyl groups may be substituted or unsubstituted. Unless otherwise specified, “substituted alkyl” groups may be substituted with one or more groups selected from halo, hydroxy, amino, alkylamino, amido, acyl, nitro, cyano, and alkoxy.

As used herein, the terms “hydroxyalkyl” or “alkylhydroxy” refer to an alkyl group, as defined above, where at least one of the hydrogen atoms is replaced with a hydroxy group. As for the alkyl group, alkylhydroxy groups can have any suitable number of carbon atoms, such as C₁₋₆. Exemplary alkylhydroxy groups include, but are not limited to, hydroxy-methyl, hydroxyethyl (where the hydroxy is in the 1- or 2-position), hydroxypropyl (where the hydroxy is in the 1-, 2- or 3-position), hydroxybutyl (where the hydroxy is in the 1-, 2-, 3- or 4-position), hydroxypentyl (where the hydroxy is in the 1-, 2-, 3-, 4- or 5-position), hydroxyhexyl (where the hydroxy is in the 1-, 2-, 3-, 4-, 5- or 6-position), 1,2-dihydroxyethyl, and the like.

As used herein, the term “heteroalkyl,” by itself or as part of another substituent, refers to an alkyl group of any suitable length and having from 1 to 3 heteroatoms such as N, O and S. Additional heteroatoms may also be useful, including, but not limited to, B, Al, Si and P. The heteroatoms may also be oxidized, such as, but not limited to, —S(O)— and —S(O)₂—. For example, heteroalkyl may include ethers, thioethers and alkyl-amines. The heteroatom portion of the heteroalkyl may replace a hydrogen of the alkyl group to form a hydroxy, thio, or amino group. Alternatively, the heteroatom portion may be the connecting atom, or be inserted between two carbon atoms. Heteroalkyl groups may be substituted or unsubstituted.

As used herein, the term “alkylene,” by itself or as part of another substituent, refers to a straight or branched, saturated, aliphatic radical having the number of carbon atoms indicated, and linking at least two other groups, i.e., a divalent hydrocarbon radical. The two moieties linked to the alkylene may be linked to the same atom or different atoms of the alkylene group. For instance, a straight chain alkylene may be the bivalent radical of —(CH₂)ₙ—, where n is 1, 2, 3, 4, 5 or 6. A branched alkylene may include one or branches having a geminal, vicinal, and/or isolated pattern. For example, an alkylene may include gem-methyl groups. Representative alkylene groups include, but are not limited to, methylene, ethylene, propylene, isopropylene, butylene, isobutylene, sec-butylene, pentylene and hexylene. Alkylene groups may be substituted or unsubstituted.

As used herein, the term “alkoxy” refers to a substituted alkyl group having an oxygen atom that connects the alkyl group to the point of attachment: alkyl-O—. As for the unsubstituted portion of the alkyl group, alkoxy groups may have any suitable number of carbon atoms, such as C₁₋₆. Alkoxy groups include, for example, methoxy, ethoxy, propoxy, isopropoxy, butoxy, 2butoxy, isobutoxy, secbutoxy, tertbutoxy, pentoxy, hexoxy, etc.

As used herein, the term “halogen” refers to fluorine, chlorine, bromine and iodine.

As used herein, the term “haloalkyl” refers to a substituted alkyl, as defined above, where some or all of the hydrogen atoms are replaced with halogen atoms. As for the unsubstituted portion of the alkyl group, haloalkyl groups may have any suitable number of carbon atoms, such as C₁₋₆. For example, haloalkyl includes trifluoromethyl, fluoromethyl, etc. In some instances, the term “perfluoro” may be used to define a compound or radical where all the hydrogens are replaced with fluorine. For example, perfluoromethane includes 1,1,1trifluoromethyl.

As used herein, the term “haloalkoxy” refers to an alkoxy group where some or all of the hydrogen atoms are substituted with halogen atoms. As for the unsubstituted portion of the alkyl group, haloalkoxy groups may have any suitable number of carbon atoms, such as C₁₋₆. The alkoxy groups may be substituted with 1, 2, 3, or more halogens. When all the hydrogens are replaced with a halogen, for Example By fluorine, the compounds are persubstituted, for example, perfluorinated. Haloalkoxy includes, but is not limited to, trifluoromethoxy, 2,2,2-trifluoroethoxy, perfluoroethoxy, etc.

As used herein, the term “amino” refers to a moiety —NR₂, wherein each R group is H or alkyl. An amino moiety may be ionized to form the corresponding ammonium cation.

As used herein, the terms “alkyl amine” or “alkylamino” refer to a substituted alkyl group as defined above, having one or more amino groups. The amino groups may be primary, secondary or tertiary. The alkyl amine may be further substituted with a hydroxy group to form an amino-hydroxy group. Alkyl amines useful in the present disclosure include, but are not limited to, ethyl amine, propyl amine, isopropyl amine, ethylene diamine and ethanolamine. The amino group may link the alkyl amine to the point of attachment with the rest of the compound, be at the omega position of the alkyl group, or link together at least two carbon atoms of the alkyl group. One of skill in the art will appreciate that other alkyl amines are useful in the present disclosure.

As used herein, the term “amido” refers to a moiety —NRC(O)R or —C(O)NR₂, wherein each R group is H or alkyl.

As used herein, the term “acyl” refers to an RC(O) group, where the R group is alkyl.

As used herein, the term “cycloalkyl,” by itself or as part of another substituent, refers to a saturated or partially unsaturated, monocyclic, fused bicyclic or bridged polycyclic ring assembly containing from 3 to 12 ring atoms, or the number of atoms indicated. Cycloalkyl may include any number of carbons, such as C₃₋₆, C₄₋₆, C₅₋₆, C₃₋₈, C₄₋₈, C₅₋₈, C₆₋₈, C₃₋₉, C₃₋₁₀, C₃₋₁₁, and C₃₋₁₂. Saturated monocyclic cycloalkyl rings include, for example, cyclopropyl, cyclobutyl, cyclopentyl, cyclohexyl, and cyclooctyl. Saturated bicyclic and polycyclic cycloalkyl rings include, for example, bicyclo[1.1.1]pentane, norbornane, [2.2.2] bicyclooctane, decahydronaphthalene and adamantane. Cycloalkyl groups may also be partially unsaturated, having one or more double or triple bonds in the ring. Representative cycloalkyl groups that are partially unsaturated include, but are not limited to, cyclobutene, cyclopentene, cyclohexene, cyclohexadiene (1,3- and 1,4-isomers), cycloheptene, cycloheptadiene, cyclooctene, cyclooctadiene (1,3-, 1,4- and 1,5-isomers), norbornene, and norbornadiene. When cycloalkyl is a saturated monocyclic C₃₋₈ cycloalkyl, exemplary groups include, but are not limited to cyclopropyl, cyclobutyl, cyclopentyl, cyclohexyl, cycloheptyl and cyclooctyl. When cycloalkyl is a saturated monocyclic C₃₋₆ cycloalkyl, exemplary groups include, but are not limited to cyclopropyl, cyclobutyl, cyclopentyl, and cyclohexyl. Cycloalkyl groups may be substituted or unsubstituted. Unless otherwise specified, “substituted cycloalkyl” groups may be substituted with one or more groups selected from halo, hydroxy, amino, alkylamino, amido, acyl, nitro, cyano, and alkoxy. The term “lower cycloalkyl” refers to a cycloalkyl radical having from three to seven carbons including, for example, cyclopropyl, cyclobutyl, cyclopentyl, cyclohexyl, and cycloheptyl.

As used herein, the term “aryl,” by itself or as part of another substituent, refers to an aromatic ring system having any suitable number of carbon ring atoms and any suitable number of rings. Aryl groups may include any suitable number of carbon ring atoms, such as C₆, C₇, C₈, C₉, C₁₀, C₁₁, C₁₂, C₁₃, C₁₄, C₁₅ or C₁₆, as well as C₆₋₁₀, C₆₋₁₂, or C₆₋₁₄. Aryl groups may be monocyclic, fused to form bicyclic (e.g., benzocyclohexyl) or tricyclic groups, or linked by a bond to form a biaryl group. Representative aryl groups include phenyl, naphthyl and biphenyl. Other aryl groups include benzyl, having a methylene linking group. Some aryl groups have from 6 to 12 ring members, such as phenyl, naphthyl or biphenyl. Other aryl groups have from 6 to 10 ring members, such as phenyl or naphthyl. Some other aryl groups have 6 ring members, such as phenyl. Aryl groups may be substituted or unsubstituted. Unless otherwise specified, “substituted aryl” groups may be substituted with one or more groups selected from halo, hydroxy, amino, alkylamino, amido, acyl, nitro, cyano, and alkoxy.

As used herein, the term “aralkyl” refers to a substituted alkyl, as defined above, where some or all of the hydrogen atoms are replaced with an aryl group as defined above. As for the unsubstituted portion of the alkyl group, aralkyl groups may have any suitable number of carbon atoms, such as C₁₋₆.

As used herein, the term “heteroaryl,” by itself or as part of another substituent, refers to a monocyclic or fused bicyclic or tricyclic aromatic ring assembly containing 5 to 16 ring atoms, where from 1 to 5 of the ring atoms are a heteroatom such as N, O or S. Additional heteroatoms may also be useful, including, but not limited to, B, Al, Si and P. The heteroatoms may be oxidized to form moieties such as, but not limited to, —S(O)— and —S(O)₂—. Heteroaryl groups may include any number of ring atoms, such as C₅₋₆, C₃₋₈, C₄₋₈, C₅₋₈, C₆₋₈, C₃₋₉, C₃₋₁₀, C₃₋₁₁, or C₃₋₁₂, wherein at least one of the carbon atoms is replaced by a heteroatom. Any suitable number of heteroatoms may be included in the heteroaryl groups, such as 1, 2, 3, 4; or 5, or 1 to 2, 1 to 3, 1 to 4, 1 to 5, 2 to 3, 2 to 4, 2 to 5, 3 to 4, or 3 to 5. For example, heteroaryl groups may be C₅₋₈ heteroaryl, wherein 1 to 4 carbon ring atoms are replaced with heteroatoms; or C₅₋₆ heteroaryl, wherein 1 to 3 carbon ring atoms are replaced with heteroatoms; or C₅₋₆ heteroaryl, wherein 1 to 4 carbon ring atoms are replaced with heteroatoms; or C₅₋₆ heteroaryl, wherein 1 to 3 carbon ring atoms are replaced with heteroatoms. The heteroaryl group may include groups such as pyrrole, pyridine, imidazole, pyrazole, triazole, tetrazole, pyrazine, pyrimidine, pyridazine, triazine (1,2,3-, 1,2,4- and 1,3,5-isomers), thiophene, furan, thiazole, isothiazole, oxazole, and isoxazole. The heteroaryl groups may also be fused to aromatic ring systems, such as a phenyl ring, to form members including, but not limited to, benzopyrroles such as indole and isoindole, benzopyridines such as quinoline and isoquinoline, benzopyrazine (quinoxaline), benzopyrimidine (quinazoline), benzopyridazines such as phthalazine and cinnoline, benzothiophene, and benzofuran. Other heteroaryl groups include heteroaryl rings linked by a bond, such as bipyridine. Heteroaryl groups may be substituted or unsubstituted. Unless otherwise specified, “substituted heteroaryl” groups may be substituted with one or more groups selected from halo, hydroxy, amino, alkylamino, amido, acyl, nitro, cyano, and alkoxy.

The heteroaryl groups may be linked via any position on the ring. For example, pyrrole includes 1-, 2- and 3-pyrrole, pyridine includes 2-, 3- and 4-pyridine, imidazole includes 1-, 2-, 4- and 5-imidazole, pyrazole includes 1-, 3-, 4- and 5-pyrazole, triazole includes 1-, 4- and 5-triazole, tetrazole includes 1- and 5-tetrazole, pyrimidine includes 2-, 4-, 5- and 6-pyrimidine, pyridazine includes 3- and 4-pyridazine, 1,2,3-triazine includes 4- and 5-triazine, 1,2,4-triazine includes 3-, 5- and 6-triazine, 1,3,5-triazine includes 2-triazine, thiophene includes 2- and 3-thiophene, furan includes 2- and 3-furan, thiazole includes 2-, 4- and 5-thiazole, isothiazole includes 3-, 4- and 5-isothiazole, oxazole includes 2-, 4- and 5-oxazole, isoxazole includes 3-, 4- and 5-isoxazole, indole includes 1-, 2- and 3-indole, isoindole includes 1- and 2-isoindole, quinoline includes 2-, 3- and 4-quinoline, isoquinoline includes 1-, 3- and 4-isoquinoline, quinazoline includes 2- and 4-quinazoline, cinnoline includes 3- and 4-cinnoline, benzothiophene includes 2- and 3-benzothiophene, and benzofuran includes 2- and 3-benzofuran.

Some heteroaryl groups include those having from 5 to 10 ring members and from 1 to 3 ring atoms including N, O or S, such as pyrrole, pyridine, imidazole, pyrazole, triazole, pyrazine, pyrimidine, pyridazine, triazine (1,2,3-, 1,2,4- and 1,3,5-isomers), thiophene, furan, thiazole, isothiazole, oxazole, isoxazole, indole, isoindole, quinoline, isoquinoline, quinoxaline, quinazoline, phthalazine, cinnoline, benzothiophene, and benzofuran. Other heteroaryl groups include those having from 5 to 8 ring members and from 1 to 3 heteroatoms, such as pyrrole, pyridine, imidazole, pyrazole, triazole, pyrazine, pyrimidine, pyridazine, triazine (1,2,3-, 1,2,4- and 1,3,5-isomers), thiophene, furan, thiazole, isothiazole, oxazole, and isoxazole. Some other heteroaryl groups include those having from 9 to 12 ring members and from 1 to 3 heteroatoms, such as indole, isoindole, quinoline, isoquinoline, quinoxaline, quinazoline, phthalazine, cinnoline, benzothiophene, benzofuran and bipyridine. Still other heteroaryl groups include those having from 5 to 6 ring members and from 1 to 2 ring heteroatoms including N, O or S, such as pyrrole, pyridine, imidazole, pyrazole, pyrazine, pyrimidine, pyridazine, thiophene, furan, thiazole, isothiazole, oxazole, and isoxazole.

As used herein the term “heterocyclyl,” by itself or as part of another substituent, refers to a saturated heterocyclyl ring system having from 3 to 15 ring members, a partially unsaturated non-aromatic ring, or a partially unsaturated, non-aromatic multiple-ring system in which one or more of the carbon atoms are each independently replaced with the same or different heteroatom such as N, O and S. Additional heteroatoms may also be useful, including, but not limited to, B, Al, Si and P. The heteroatoms may be oxidized to form moieties such as, but not limited to, —S(O)— and —S(O)₂—. Heterocyclyl groups may include any number of ring atoms, such as, C₃₋₆, C₄₋₆, C₅₋₆, C₃₋₈, C₄₋₈, C₅₋₈, C₆₋₈, C₃₋₉, C₃₋₁₀, C₃₋₁₁, C₃₋₁₂, or C₃₋₁₅, wherein at least one of the carbon atoms is replaced by a heteroatom. Any suitable number of carbon ring atoms may be replaced with heteroatoms in the heterocyclyl groups, such as 1, 2, 3, or 4, or 1 to 2, 1 to 3, 1 to 4, 2 to 3, 2 to 4, or 3 to 4. The heterocyclyl group may include groups such as aziridine, azetidine, pyrrolidine, piperidine, azepane, azocane, quinuclidine, pyrazolidine, imidazolidine, piperazine (1,2-, 1,3- and 1,4-isomers), oxirane, oxetane, tetrahydrofuran, oxane (tetrahydropyran), oxepane, thiirane, thietane, thiolane (tetrahydrothiophene), thiane (tetrahydrothiopyran), oxazolidine, isoxazolidine, thiazolidine, isothiazolidine, dioxolane, dithiolane, morpholine, thiomorpholine, dioxane, or dithiane. One or more heterocyloalkyl rings of heterocyclyl groups may also be fused to aromatic or non-aromatic rings to form members including, but not limited to, indoline. Heterocyclyl groups thus include partially unsaturated ring systems containing one or more double bonds, including fused ring systems with one aromatic ring and one non-aromatic ring, but not fully aromatic ring systems. Examples include dihydroquinolines, e.g., 3,4-dihydroquinoline, dihydroisoquinolines, e.g., 1,2-dihydroisoquinoline, tetrahydroquinolines, e.g., 1,2,3,4-tetrahydroquinoline, tetrahydroisoquinoline, dihydroimidazole, tetrahydroimidazole, etc., isoindoline, isoindolones (e.g., isoindolin-1-one), isatin, dihydrophthalazine, quinolinone, spiro[cyclopropane-1,1′-isoindolin]-3′-one, and the like. Heterocyclyl groups may have 3-15 members, or 3-12 members, or 3-10 members, or 3-7 members, or 5-6 members. Heterocyclyl groups may be unsubstituted or substituted. Unless otherwise specified, “substituted heterocyclyl” groups may be substituted with one or more groups selected from halo, hydroxy, amino, oxo (═O), alkylamino, amido, acyl, nitro, cyano, and alkoxy.

The heterocyclyl groups may be linked via any position on the ring. For example, aziridine may be 1- or 2-aziridine, azetidine may be 1- or 2-azetidine, pyrrolidine may be 1-, 2- or 3-pyrrolidine, piperidine may be 1-, 2-, 3- or 4-piperidine, pyrazolidine may be 1-, 2-, 3-, or 4-pyrazolidine, imidazolidine may be 1-, 2-, 3- or 4-imidazolidine, piperazine may be 1-, 2-, 3- or 4-piperazine, tetrahydrofuran may be 1- or 2-tetrahydrofuran, oxazolidine may be 2-, 3-, 4- or 5-oxazolidine, isoxazolidine may be 2-, 3-, 4- or 5-isoxazolidine, thiazolidine may be 2-, 3-, 4- or 5-thiazolidine, isothiazolidine may be 2-, 3-, 4- or 5-isothiazolidine, and morpholine may be 2-, 3- or 4-morpholine.

As used herein, the term “nitro” refers to the moiety —NO₂.

As used herein, the term “cyano” refers to a carbon atom triple-bonded to a nitrogen atom (i.e., the moiety —C≡N).

As used herein, the term “sulfonyl” refers to a moiety —SO₂R, wherein the R group is alkyl, haloalkyl, aryl, or halogen. “Alkylsulfonyl” refers to a sulfonyl moiety wherein the R group is alkyl. “Sulfonyl halide” refers to a sulfonyl moiety wherein the R group is halogen.

As used herein, the term “salt” refers to acid or base salts of the compounds of the present disclosure. An “agriculturally acceptable salt” is one that is compatible with other ingredients of a formulation composition containing the compound, and that is not deleterious to a recipient thereof. It is thus understood that the agriculturally acceptable salts are non-toxic. Illustrative examples of salts are mineral acid (hydrochloric acid, hydrobromic acid, phosphoric acid, and the like) salts, organic acid (acetic acid, propionic acid, glutamic acid, citric acid and the like) salts, and quaternary ammonium (methyl iodide, ethyl iodide, and the like) salts. Salts of the acidic compounds of the present disclosure are salts formed with bases, namely cationic salts such as alkali and alkaline earth metal salts, such as sodium, lithium, potassium, calcium, magnesium, as well as ammonium salts, such as ammonium, trimethyl-ammonium, diethylammonium, and tris-(hydroxymethyl)-methyl-ammonium salts. Similarly acid addition salts, such as of mineral acids, organic carboxylic and organic sulfonic acids, e.g., hydrochloric acid, methanesulfonic acid, maleic acid, are also possible provided a basic group, such as pyridyl, constitutes part of the structure. The neutral forms of the compounds may be regenerated by contacting the salt with a base or acid and isolating the parent compound in the conventional manner. The parent form of the compound differs from the various salt forms in certain physical properties, such as solubility in polar solvents, but otherwise the salts are equivalent to the parent form of the compound for the purposes of the present disclosure.

As used herein, the term “solvate” refers to a compound that is complexed to at least one solvent molecule. The compounds of the present disclosure may be complexed with from 1 to 10 solvent molecules. In some embodiments, the solvent is water and the solvate is a hydrate.

As used herein, the term “agriculturally acceptable carrier” refers to a substance that aids the administration of an active agent to and absorption by an agricultural crop and may be included in the compositions of the present disclosure without causing a significant adverse toxicological effect on the agricultural crop. An agriculturally acceptable carriers is thus compatible with the other ingredients of the formulation and not deleterious to the environment or organism (e.g., plant) to which it is applied. Non-limiting examples of agriculturally acceptable carriers include water, NaCl, normal saline solutions, normal sucrose, normal glucose, binders, fillers, disintegrants, lubricants, coatings, and the like. One of skill in the art will recognize that other agriculturally acceptable carriers are useful in the present disclosure.

As used herein, the term “degradation efficiency” refers to a measure of an ability of a molecule (e.g., a targeted protein degrader) to induce degradation of a particular substance (e.g., a targeted protein). The degradation efficiency of a molecule can be measured in terms of, for example, a half-maximal degradation concentration (DC₅₀) or a maximal degradation (Dₘₐₓ). The half-maximal degradation concentration (DC₅₀) of a molecule is the concentration of the molecule at which degradation of 50% of the targeted substance has been induced. The maximal degradation (Dₘₐₓ) of a molecule is the maximal observed percent of the targeted substance that the molecule induces the degradation of.

### B. Compounds

In one aspect, the disclosure provides a compound that is a proteolysis targeting chimera (PROTAC). A PROTAC according to the present invention is a bifunctional compound having a binding ligand that binds a protein in an insect cell, where this binding ligand is referred to herein as a protein targeting moiety (PTM). The PTM is covalently linked via a linker (L) to another ligand that binds to a ubiquitin ligase, where this binding ligand is referred to herein as a ligase targeting moiety (LTM). The bound protein is then targeted for degradation through the ubiquitin-proteasome system. PROTACs may be used to inhibit or degrade essentially any protein of interest in an insect (e.g., proteins required for the insect and/or arachnid to maintain its normal physiological and biochemical functions, proteins that limit the insect's and/or arachnid's ability to feed, grow, or survive, or proteins involved in processes such as development, metabolism, or neurotransmission). The provided PROTACs may be designed by considering multiple factors, including the type of ligase being targeted, the selected configuration of the PROTAC linker, the choice of the POI ligand and its binding site, the choice of the ligase ligand and its binding site, and the nature of the protein-protein interaction interface between the ligase and the POI. All these factors may affect the structure and stability of ternary complexes.

The half-maximal inhibitory concentration (IC₅₀) values of the LTMs and the bifunctional compounds, described herein, are measures of the binding affinity exhibited by the LTMs and bifunctional compounds, respectively. The IC₅₀ values may be determined according to any method known in the art such as, for example, a fluorescent polarization assay.

In some embodiments described herein, the LTM exhibits a binding affinity to the E3 ubiquitin ligase (e.g., VHL or CRBN) with an IC₅₀ of less than about 1 mM. For example, in some embodiments described herein, the LTMs described herein demonstrate an activity with an IC₅₀ of less than about 500 μM, less than 200 μM, less than about 100 μM, less than about 50 μM, less than about 10 μM, less than about 5 μM, or less than about 1 μM.

In some embodiments described herein, the bifunctional compounds described herein exhibit a binding affinity to the E3 ubiquitin ligase (e.g., VHL or CRBN) and/or the target protein with an IC₅₀ of less than about 100 μM, less than about 50 μM, less than about 10 μM, less than about 1 μM, less than about 500 nM, less than about 100 nM, less than about 50 nM, less than about 10 nM, less than about 1 nM, less than about 500 pM, less than about 100 pM, less than about 50 pM, less than about 10 pM, less than about 1 pM, less than about 0.5 pM, less than about 0.1 pM, less than about 0.05 pM, less than about 0.01 pM, less than about 0.005 pM, or less than about 0.001 pM.

In some embodiments described herein, the D_{Max} of the bifunctional compounds described herein may be determined according to any method known in the art such as, for example, a western blot analysis. In some embodiments described herein, the bifunctional compounds have a D_{Max} greater than or equal to 80%. In some embodiments described herein, the bifunctional compounds have a D_{Max} greater than 30%, greater than 50%, greater than 75%, or greater than or equal to 80%. In some embodiments described herein, the bifunctional compounds have a D_{Max} greater than 50%. In some embodiments described herein, the bifunctional compounds have a D_{Max} greater than 75%.

In some embodiments described herein, the DC₅₀ value of the bifunctional compounds described herein may be determined according to any method known in the art such as, for example, a western blot analysis. In some embodiments described herein, the DC₅₀ value of the bifunctional compounds is less than about 10 μM, less than about 1 μM, less than about 500 nM, less than about 100 nM, less than about 50 nM, less than about 100 nM, less than about 50 nM, less than about 10 nM or less than about 2.5 nM. In some embodiments described herein, the DC₅₀ value of the bifunctional compounds is less than 10 nM. In some embodiments described herein, the DC₅₀ value of the bifunctional compounds is less than 2.5 nM.

In some embodiments described herein, the bifunctional compounds have a D_{Max} greater than 30%, greater than 50%, greater than 75%, or greater than or equal to 80% and the DC₅₀ value of the bifunctional compounds is less than about 10 μM, less than about 1 μM, less than about 500 nM, less than about 100 nM, less than about 50 nM, less than about 100 nM, less than about 50 nM, less than about 10 nM or less than 2.5 nM.

In some embodiments described herein, the bifunctional compound includes compounds having a DC₅₀ of <about 2.5 nM, wherein the DC₅₀ is optionally determined as described herein. In some embodiments described herein, the bifunctional compound includes compounds having a DC₅₀ that is ≥about 2.5 nM and <about 10 nM, wherein the DC₅₀ is optionally determined as described herein. In some embodiments described herein, the bifunctional compound includes compounds having a DC₅₀ of ≥about 2.5 nM and <about 30 nM, wherein the DC₅₀ is optionally determined as described herein. In some embodiments described herein, the bifunctional compound includes compounds having a DC₅₀ of ≥about 30 nM, wherein the DC₅₀ is optionally determined as described herein. In some embodiments described herein, a compound or compounds having a DC₅₀ of ≥about 30 nM is or are excluded. In some embodiments described herein the DC₅₀ value of the bifunctional compounds described herein can be determined according to any method known in the art, such as, for example, a western blot analysis.

In some embodiments described herein, the bifunctional compound includes compounds having a D_{Max} of ≥about 75% degraded, wherein the D_{Max} is optionally determined as described herein. In some embodiments described herein, the bifunctional compound includes compounds having a D_{Max} that is >about 50% degraded and <about 75% degraded, wherein the D_{Max} is optionally determined as described herein. In some embodiments described herein, the bifunctional compound includes compounds having a D_{Max} of ≤about 30% degraded, wherein the D_{Max} is optionally determined as described herein. In some embodiments described herein a compound or compounds having a D_{Max} of ≤about 30% degraded is or are excluded, wherein the D_{Max} may be determined as described herein. In some embodiments described herein a compound or compounds having a D_{Max} of ≤about 50% degraded is or are excluded, wherein the D_{Max} may be determined as described herein. In some embodiments described herein the D_{Max} value of the bifunctional compounds described herein can be determined according to any method known in the art, such as, for example, a western blot analysis or as described herein.

### 1. Insect Ubiquitin Ligases and Ligase Targeting Moieties (LTMs)

In some embodiments, cheminformatics and computational chemistry approaches (e.g., ligand conformational sampling, PROTAC conformational sampling, 3D docking, protein-protein docking, molecular dynamics, machine learning) are used to design ligands for insect ligases. Such structures may then be optimized through rational medicinal chemistry optimization. See, for example, Ishida, T. and Ciulli, A. (2021) SLAS Discovery 26(4) 484-502.

In some embodiments, one or more known ubiquitin ligase binders are used in the compounds and methods provided herein. Such binders are disclosed in U.S. Pat. Nos. 9,694,084; 9,938,264; 10,071,164; 10,239,888; 10,336,744; 10,450,310; 10,464,925; 10,584,101; 10,723,717; 10,730,862; 10,730,870; 10,772,962; 11,242,344; U.S. Patent Application Publication Nos: 2015/0291562; 2015/0119435; 2016/0058872; 2017/0008904; 2018/0147202; 2019/0127359; and PCT Publication Nos: WO2000/047220; WO2018/144649; WO2021/127278. All of these are herein incorporated by reference in their entirety. Other E3 ligase ligands include those described in M. Toure, C. M. Crews, Angew. Chem. Int. Ed. 2016, 55, 1966; T. Uehara et al. Nature Chemical Biology 2017, 13, 675; WO2017/176708; US2017/0281784; WO2017/161119; WO2017/176957; WO2017/176958; WO2015/160845; US2015/0291562; WO2016/197032; WO2016/105518; US2018/0009779; WO2017/007612; WO2018/0134684; WO2013/106643; US2014/0356322; WO2002/020740; US2002/0068063; WO2012/078559; US2014/0302523; WO2012/003281; US2013/0190340; US2016/0022642; WO2014/063061; US2015/0274738; WO2016/118666; US2016/0214972; WO2016/149668; US2016/0272639; WO2016/169989; US2018/0118733; WO2016/197114; US2018/0147202; WO2017/011371; US2017/0008904; WO2017/011590; US2017/0037004; WO2017/079267; US2017/0121321; WO2017/117473; WO2017/117474; WO2013/106646; WO2014/108452; WO2017/197036; US2019/0076540; WO2017/197046; US2019/0076542; WO2017/197051; US2019/0076539; WO2017/197055; US2019/0076541; and WO2017/197056, the entirety of each of which is herein incorporated by reference.

In some embodiments, the ubiquitin ligase is Cereblon, and the ligase targeting moiety is an N-substituted 1,3-dioxoisoindolinyl moiety, which is optionally substituted with one or more substituents independently selected from the group consisting of C₁₋₆ alkyl, halo, hydroxy, amino, C₁₋₆ alkylamino, C₁₋₆ amido, C₁₋₆ acyl, nitro, cyano, and C₁₋₆ alkoxy.

In some embodiments, the ubiquitin ligase is VHL. The von Hippel-Lindau tumor suppressor (VHL) is an E3 ubiquitin ligase. VHL comprises the substrate recognition subunit/E3 ubiquitin ligase complex VCB, which includes elongins B and C, and a complex including Cullin-2 and Rbx1. The primary substrate of VHL is Hypoxia Inducible Factor 1α (HIF-1α), a transcription factor. In this instance targeting moieties may be selected from those disclosed in U.S. Pat. Nos. 10,730,870; 10,071,164; 10,730,862; 10,772,962; and 11,242,344; all of which are herein incorporated by reference.

In some embodiments, the VHL targeting moiety has a structure according to the formula

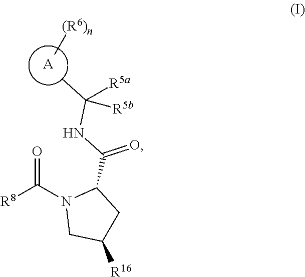

wherein R^{5a} and R^{5b} may each independently be hydrogen, hydroxy, amine, haloalkyl, optionally substituted alkyl, optionally substituted alkoxy, optionally substituted hydroxyl alkyl, optionally substituted alkylamine, optionally substituted amide, optionally substituted alkyl-amide, optionally substituted alkyl-cyano, optionally substituted alkyl-phosphate, optionally substituted aryl, optionally substituted alkyl-aryl, optionally substituted heteroalkyl, optionally substituted alkyl-heterocyclyl, optionally substituted alkoxy-heterocyclyl, COR¹⁴, alkyl-COR¹⁴, CONR^{15a}R^{15b}, NHCOR¹⁴, NHCH₃COR¹⁴, or —X-L¹. Alternatively, R^{5a} and R^{5b} are combined with the carbon atom to which they are attached to form an optionally substituted 3- to 5-membered cycloalkyl, heterocyclyl, spirocycloalkyl, or spiroheterocyclyl, wherein the spiroheterocyclyl is not epoxide or aziridine. Each R⁶ may independently be C₁₋₆ alkyl, halogen, C₁₋₆ haloalkyl, hydroxy, C₁₋₆ alkoxy, C₁₋₆ haloalkoxy, C₃₋₈ cycloalkyl, C₆₋₁₂ aryl, C₅₋₁₂ heteroaryl, C₃₋₁₅ heterocyclyl, cyano, nitro, NR^{15a}R^{15b}, OR¹⁴, CONR^{15a}R^{15b}, NR^{15a} COR^{15b}, SO₂NR^{15a}R^{15b}, NR^{15a}SO₂R^{15b} or —X-L¹, wherein the alkyl, haloalkyl, alkoxy, cycloalkyl, aryl, heteroaryl, and heterocyclyl are optionally substituted with 1 to 4 R^{6a} groups. R⁸ may be an optionally substituted aryl, optionally substituted heteroaryl, or

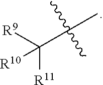

R⁹ and R¹⁰ may independently be hydrogen, optionally substituted alkyl, optionally substituted cycloalkyl, optionally substituted hydroxyalkyl, optionally substituted heteroaryl, haloalkyl, or

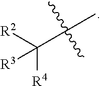

Alternatively, R⁹ and R¹⁰ may be combined with the carbon atom to which they are attached to form an optionally substituted cycloalkyl. R² and R³ may each independently be hydrogen, C₁₋₆ alkyl, or C₁₋₆ hydroxyalkyl. Alternatively, R² and R³ may be combined with the carbon to which they are attached to form a C₃₋₈ cycloalkyl, C₆₋₁₂ aryl, or C₅₋₁₂ heteroaryl, wherein the cycloalkyl, aryl and heteroaryl are optionally substituted with 1 to 4 R^{2a} groups. R⁴ may be hydrogen, C₁₋₆ alkyl, C₁₋₆ hydroxyalkyl, or —X-L¹. R¹¹ may be an optionally substituted heterocyclyl, optionally substituted alkoxy, optionally substituted heteroaryl, optionally substituted aryl,

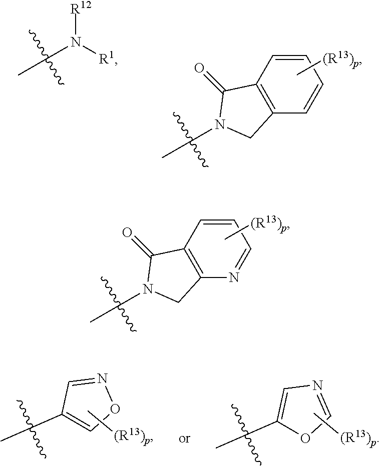

R¹ may be hydrogen, optionally substituted alkyl, optionally substituted alkylcarbonyl, optionally substituted (cycloalkyl)alkylcarbonyl, optionally substituted aralkylcarbonyl, optionally substituted arylcarbonyl, optionally substituted (heterocyclyl)carbonyl, optionally substituted aralkyl, —C(O)R^{1a}, or —C(O)—X-L¹. R^{1a} may be C₁₋₆ alkyl, C₃₋₈ cycloalkyl, C₆₋₁₂ aryl, or C₅₋₁₂ heteroaryl, wherein the cycloalkyl, aryl, and heteroaryl are optionally substituted with 1 to 4 R^{1b} groups. Each R^{1b}, R^{2a}, and R^{6a} may independently be C₁₋₆ alkyl, cyano, halogen, C₁₋₆ haloalkyl, hydroxy, C₁₋₆ alkoxy, C₁₋₆ haloalkoxy, or —X-L¹. R¹² may be hydrogen or optionally substituted alkyl. Each R¹³ may independently be hydrogen, halogen, optionally substituted alkoxy, cyano, optionally substituted alkyl, haloalkyl, haloalkoxy, or —X-L¹. Each R¹⁴ may independently be hydrogen, OH, O—C₁₋₆ alkyl, optionally substituted alkyl, or NR^{15a}R^{15b}. R^{15a} and R^{15b} may each independently be hydrogen, optionally substituted alkyl, or optionally substituted cycloalkyl, or are combined with the nitrogen atom to which they are attached to form a 4- to 6-membered heterocyclyl. R¹⁶ is hydroxy, a group that can be metabolized to hydroxy, or sulfonyl halide. “A” may be optionally substituted phenyl, optionally substituted napthyl, or an optionally substituted 5- to 10-membered heteroaryl. X may be a bond, CH₂, NH, NMe, O, or S. L¹ is a site of attachment to the linker. The subscripts n and p may each independently be an integer from 0 to 4. At least one —X-L¹ is present in the compound of Formula (I) when the compound is a bifunctional compound, e.g., PROTAC, having the general structure LTM-L¹-PTM.

In some embodiments, the VHL targeting moiety has a structure according to the formula

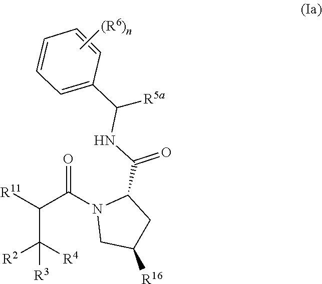

wherein R¹ may be hydrogen, C₁₋₆ alkyl, —C(O)R^{1a}, or —C(O)—X-L¹. R⁴ may be hydrogen, C₁₋₆ alkyl, C₁₋₆ hydroxyalkyl, or —X-L¹. R^{5a} may be hydrogen, C₁₋₆ alkyl, halogen, C₁₋₆ haloalkyl, C₁₋₆ alkyl-amide, hydroxy, C₁₋₆ alkoxy, C₁₋₆ haloalkoxy or —X-L¹. Each R⁶ may independently be C₁₋₆ alkyl, halogen, C₁₋₆ haloalkyl, hydroxy, C₁₋₆ alkoxy, C₁₋₆ haloalkoxy, C₃₋₈ cycloalkyl, C₆₋₁₂ aryl, C₅₋₁₂ heteroaryl, OR¹⁴, or —X-L¹, wherein the cycloalkyl, aryl, and heteroaryl are optionally substituted with 1 to 4 R^{6a} groups. Other features of formula (Ia) are as described above for formula (I).

In some embodiments, R¹ is —C(O)R^{1a} or —C(O)—X-L¹. In some embodiments, R¹ is —C(O)R^{1a}. In some embodiments, R^{1a} is C₁₋₆ alkyl or C₃₋₈ cycloalkyl, wherein the cycloalkyl is optionally substituted with 1 to 4 R^{1b} groups. In some embodiments, R^{1a} is C₁₋₆ alkyl or cyclopropyl, wherein the cyclopropyl is optionally substituted with 1 to 4 R^{1b} groups. In some embodiments, R^{1a} is cyclopyropyl optionally substituted with 1 to 4 R^{1b} groups. In some embodiments, R^{1a} is fluorocyclopropyl. In some embodiments, R^{1a} is C₁₋₆ alkyl. In some embodiments, R^{1a} is methyl. In some embodiments, R¹ is —C(O)—X-L¹.

In some embodiments, R² and R³ are each independently C₁₋₆ alkyl. In some embodiments, R² and R³ are each methyl.

In some embodiments, R⁴ is C₁₋₆ alkyl or —X-L¹. In some embodiments, R⁴ is C₁₋₆ alkyl. In some embodiments, R⁴ is methyl. In some embodiments, R⁴ is —X-L¹. In some embodiments, R⁴ is —SL¹.

In some embodiments, R^{5a} is hydrogen, C₁₋₆ alkyl, hydroxy, C₁₋₆ alkoxy or —X-L¹. In some embodiments, R^{5a} is hydrogen, methyl or —X-L¹.

In some embodiments, each R⁶ is independently C₁₋₆ alkyl, hydroxy, C₁₋₆ alkoxy, C₆₋₁₂ aryl, C₅₋₁₂ heteroaryl, or —X-L¹, wherein the aryl and heteroaryl are optionally substituted with 1 to 4 R^{6a} groups. In some embodiments, each R⁶ is independently C₅₋₁₂ heteroaryl and —X-L¹, wherein the heteroaryl is optionally substituted with 1 to 4 R^{6a} groups. In some embodiments, each R⁶ is independently thiazole or —X-L¹, wherein the thiazole is optionally substituted with 1 to 4 R^{6a} groups. In some embodiments, one R⁶ is thiazole optionally substituted with 1 to 4 R^{6a} groups. In some embodiments, one R⁶ is thiazole optionally substituted with 1 to 4 C₁₋₆ alkyl groups. In some embodiments, one R⁶ is methylthiazole. In some embodiments, one R⁶ is —X-L¹. In some embodiments, one R⁶ is —O-L¹. In some embodiments, one R⁶ is methoxy. In some embodiments, n is 2 and one R⁶ is methylthiazole and one R⁶ is methoxy. In some embodiments, n is 2 and one R⁶ is methylthiazole and one R⁶ is —X-L¹.

In some embodiments, R¹⁶ is hydroxy. In some embodiments, R¹⁶ is sulfonyl halide. In some embodiments, R¹⁶ is sulfonyl fluoride.

In some embodiments, subscript n is 1 or 2. In some embodiments, subscript n is 1. In some embodiments, subscript n is 2.

In some embodiments, the VHL targeting moiety has a structure according to the formula

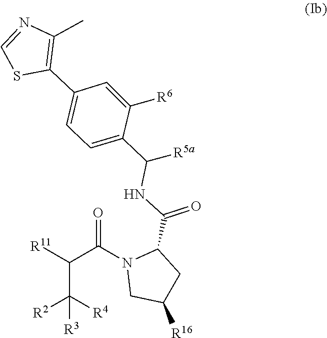

wherein R², R³, R⁴, R^{5a}, R⁶, R¹¹, and R¹⁶ are as defined above.

In some embodiments, the VHL targeting moiety has a structure that is

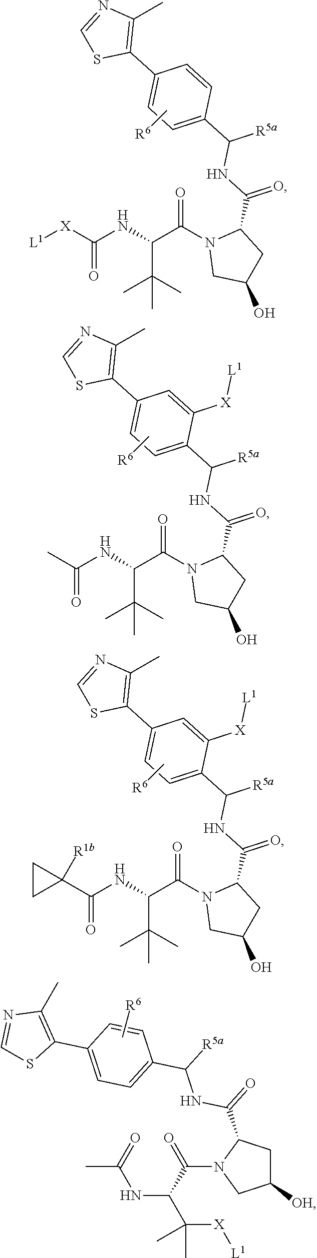

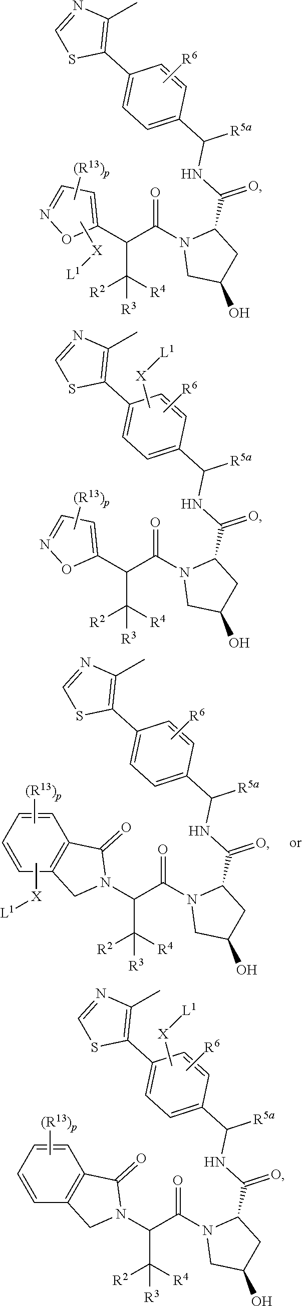

wherein R^{1b}, R², R³, R⁴, R^{5a}, R⁶, R¹³, X, L¹, and p are as defined above.

### 2. Linkers

A linker (L) is generally used to connect the PTM to the compound of Formula I. In some embodiments, L is a bond (i.e., absent). In some embodiments, L is a chemical linker. In some embodiments, the linker is a connector with a linear non-hydrogen atom number in the range of 1 to 20, e.g., in the range of 1 to 12, in the range of 3 to 14, in the range of 5 to 16, in the range of 7 to 18, or in the range of 9 to 20. The connector may contain functional groups including, but not limited to, ethers, amides, alkanes and alkyl groups, alkenes and alkenyl groups, alkynes and alkynyl groups, ketones, hydroxyls, carboxylic acids, thioethers, sulfoxides, and sulfones. The linker may contain aryl groups, heteroaryl groups, cyclic groups (including heterocyclic and carbocyclic monocycles, bicycles, tricycles). Substitution including, but not limited to, one or more of halo, such as Cl, F, Br, I, hydroxy, alkyl, amino, alkylamino, amido, acyl, nitro, cyano, and alkoxy may be included in the linker. Examples of suitable linker moieties include, but are not limited to, those disclosed in WO 2013/106643, WO 2015/160845, WO 2016/149668, WO 2016/197032, WO 2017/011371, WO 2017/011590, WO 2018/144649, and WO 2019/148055, which are incorporated herein by reference in their entirety.

Judicious linker design facilitates binding to the target protein and the ubiquitin ligase, influencing degradation efficiency as well as having a significant influence on the overall molecular properties of the PROTAC. The linker structure contributes to achieving appropriate biological function by providing a beneficial combination of cellular uptake, ternary complex geometry, stability, and aqueous solubility. The choice of linker may be informed by, for example, the E3 ligase ligand, the target-binding ligand, and both the identity and attachment positions of the linker. Linkers as disclosed herein may be tested with ligase targeting moieties and protein targeting moieties in various combinations.

In some embodiments, the linker has a structure -L²L³-. The L² and L³ components of the linker structure may each independently be a bond, a divalent polymer moiety, or C₁₋₃₀ alkylene, wherein one or more carbon atoms in each C₁₋₃₀ alkylene is optionally and independently replaced by O, C(O), S, or NR⁷. One or more groupings of adjacent carbon atoms in each C₁₋₃₀ alkylene may optionally and independently be replaced by —NR⁷(CO) or (CO)NR⁷. One or more groupings of adjacent carbon atoms in each C₁₋₃₀ alkylene may be optionally and independently replaced by a 4- to 8-membered, divalent carbocycle or a 4- to 8-membered, divalent heterocycle having one to four heteroatoms selected from O, S, and N. Each R⁷ may independently be hydrogen or C₁₋₆ alkyl.

In some embodiments, L is a C₁₋₆ alkylene diradical linker. In some embodiments, L is a methylene linker. In some embodiments, L is an ethylene linker. In some embodiments, L is a —CH₂(OCH₂CH₂)ⱼ— diradical linker, where subscript j is an integer ranging from 1 to 10. In some embodiments, L is —CH₂(OCH₂CH₂)ⱼ—. In some embodiments, L is oxy-C₁₋₆ alkylene (e.g., oxymethylene, oxyethylene, or oxypropylene), optionally substituted with C₁₋₆ alkyl (e.g., isopropyl) or C₃₋₈ cycloalkyl. In some embodiments, L is —NH₂CH₂CH₂— or —C(O)NHCH₂CH₂—.

In some embodiments, L is a covalently bound chemical linker group having the chemical structure -(A^{L})q-, where q is greater than or equal to 1 and each A^{L} is independently CR^{L1}R^{L2}, O, S, SO, SO₂, NR^{L3}, SO₂NR^{L3}, SONR^{L3}, CONR^{L3}, NR^{L3}CONR^{L4}, NR^{L3}SO₂NR^{L4}, CO, CR^{L1}═CR^{L2}, C≡C, C₃₋₁₁ cycloalkyl optionally substituted with 1-6 R^{L1} groups, C₅₋₁₃ spirocycloalkyl optionally substituted with 1-9 R^{L1} groups, C₃₋₁₁ heterocyclyl optionally substituted with 1-6 R^{L1} groups, C₅₋₁₃ spiroheterocyclyl optionally substituted with 1-8 R^{L1} groups, aryl optionally substituted with 1-6 R^{L1} groups, or heteroaryl optionally substituted with 1-6 R^{L1} groups. R^{L1} and R^{L2} are each independently optionally linked to other groups to form cycloalkyl and/or heterocyclyl moiety. R^{L1} and R^{L2} also are each independently optionally substituted with 1-4 R^{L5} groups. R^{L1}, R^{L2}, R^{L3}, R^{L4} and R^{L5} are each independently H, halo, C₁₋₈ alkyl, O(C₁₋₈ alkyl), NH(C₁₋₈ alkyl), N(C₁₋₈ alkyl)₂, C₃₋₁₁ cycloalkyl, aryl, heteroaryl, C₃₋₁₁ heterocyclyl, O(C₃₋₈ cycloalkyl), NH(C₃₋₈ cycloalkyl), N(C₃₋₈ cycloalkyl)₂, N(C₃₋₈ cycloalkyl)(C₁₋₈ alkyl), OH, NH₂, SO₂(C₁₋₈ alkyl), CC(C₁₋₈ alkyl), CCH, CH═CH(C₁₋₈ alkyl), C(C₁₋₈ alkyl)═CH(C₁₋₈ alkyl), C(C₁₋₈ alkyl)═C(C₁₋₈ alkyl)₂, CO(C₁₋₈ alkyl), CO₂H, halogen, CN, CF₃, CHF₂, CH₂F, NO₂, SF₅, SO₂NH(C₁₋₈ alkyl), SO₂N(C₁₋₈ alkyl)₂, SONH(C₁₋₈ alkyl), SON(C₁₋₈ alkyl)₂, CONH(C₁₋₈ alkyl), and CON(C₁₋₈ alkyl)₂.

In some embodiments, L comprises one or more ethylene glycol diradical moieties, one or more of which is optionally replaced by a moiety independently selected from:

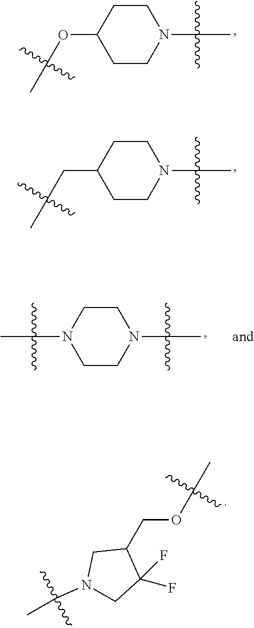

In some embodiments, the linker contains a diradical derived from a compound having two reactive groups (including, but not limited to, aldehydes, carboxylates, activated esters, amines, alcohols, and ionizable CH bonds), which may be the same or different, that react with complementary moieties in the protein targeting moiety or ligase targeting moiety. Examples of such compounds include, but are not limited to the following.
3-(5-(2-aminoethoxy)-2-fluorophenyl)propanal
N1-((S)-2-(3-isopropylphenoxy)propyl)-N3-((1s,3R)-3-(m-tolyloxy)cyclobutyl)propane-1,3-diamine
(1r,3R)—N-(4,4-dimethyl-5-(3-((1s,3S)-3-(methylamino)cyclobutoxy)phenyl)pentyl)-3-((2-ethylbenzofuran-5-yl)oxy)cyclobutan-1-amine
(1r,3r)-3-((2-(3-((2-((2-ethylbenzofuran-6-yl)oxy)propyl)amino)propyl)benzofuran-6-yl)oxy)-N-methylcyclobutan-1-amine
1-(2-ethoxyethyl)-4-(4-(1-(methylamino)ethyl)phenyl)pyridin-2(1H)-one
1-(4-(5-(2-ethoxyethyl)pyrimidin-2-yl)phenyl)-N-methylethan-1-amine
1-(4-(5-ethoxypenta-1,3-diyn-1-yl)phenyl)-N-methylethan-1-amine
1-(4-(3-(3-ethoxypropoxy)prop-1-yn-1-yl)phenyl)-N-methylethan-1-amine
1-(4-(4-(2-ethoxyethyl)piperazin-1-yl)phenyl)-N-methylethan-1-amine
1-(4-((S)-3-ethoxypyrrolidin-1-yl)phenyl)-N-methylethan-1-amine
(2-ethoxyphenyl)((3R)-3-((3-(((3R)-1-(4-(1-(methylamino)ethyl)phenyl)pyrrolidin-3-yl)oxy)propyl)amino)pyrrolidin-1-yl)methanone
1-(4-((R)-3-ethoxypyrrolidin-1-yl)phenyl)-N-methylethan-1-amine
(Z)—N-methyl-2-(2-(1-(3-methylpent-1-en-1-yl)hydrazineyl)ethoxy)ethan-1-amine
1-((2R)-1-ethyl-2-methylpiperidin-4-yl)-4-methylpiperazine-1-((3R)-1-ethyl-3-methylpiperidin-4-yl)-4-methylpiperazine
(S)—N-ethyl-3-((2-(3-((2-((2-methylbenzofuran-5-yl)oxy)propyl)amino)propyl)benzofuran-5-yl)oxy)propan-1-amine
(S)-2-(4-(4-ethylphenyl)-1H-imidazol-1-yl)-N-methylpropan-1-amine
(S)—N-methyl-2-(3-propylphenoxy)propan-1-amine
(S)-2-((5-ethoxypyridin-2-yl)oxy)-N-methylpropan-1-amine
(S)—N-methyl-2-((4-(3-((2-(3-propylphenoxy)ethyl)amino)propyl)pyridin-2-yl)oxy)propan-1-amine
(S)-2-((4-ethylpyridin-2-yl)oxy)-N-methylpropan-1-amine
1-((2S)-1-ethyl-2-methylpiperidin-4-yl)-4-methylpiperazine
2-((3S)-1-ethyl-3-methylpiperidin-4-yl)-6-(4-((3R)-3-methyl-4-(4-methylpiperazin-1-yl)piperidin-1-yl)butyl)-2,6-diazaspiro[3.3]heptane
1-((3S)-1-ethyl-3-methylpiperidin-4-yl)-4-methylpiperazine
1-((2R,5S)-1-ethyl-2,5-dimethylpiperidin-4-yl)-4-methylpiperazine
(R)—N1-(2-((4-methylpyridin-2-yl)oxy)propyl)-N3-(2-((1-propylpiperidin-4-yl)oxy)ethyl)propane-1,3-diamine
(R)—N-ethyl-2-((2-methylbenzofuran-5-yl)oxy)propan-1-amine
(R)-2-(4-(4-ethylphenyl)-1H-imidazol-1-yl)-N-methylpropan-1-amine
(R)—N-methyl-2-(3-propylphenoxy)propan-1-amine
(R)-2-((5-ethoxypyridin-2-yl)oxy)-N-methylpropan-1-amine
3-(5-(2-phenoxyethoxy)pentyl)isoxazole
3-(4-(4-phenylpiperazin-1-yl)butyl)isoxazole
3-(4-(3-phenoxypropoxy)butyl)isoxazole
3-(3-(4-phenoxybutoxy)propyl)isoxazole
5-(4-(4-(2-(3-(isoxazol-3-yl)propoxy)ethyl)piperazin-1-yl)phenethyl)-3-(6-(4-phenylpiperazin-1-yl)hexyl)isoxazole
3-(2-((5-phenoxypentyl)oxy)ethyl)isoxazole
5-(4-(2-(2-(isoxazol-3-yl)ethoxy)ethoxy)phenethyl)-3-(5-phenoxypentyl)isoxazole
3-(2-(2-(2-phenoxyethoxy)ethoxy)ethyl)isoxazole
3-(((6-phenoxyhexyl)oxy)methyl)isoxazole
5-(4-((5-(isoxazol-3-ylmethoxy)pentyl)oxy)phenethyl)-3-(2-(4-phenoxybutoxy)ethyl)isoxazole
5-(4-(4-(4-(isoxazol-3-ylmethoxy)butyl)piperazin-1-yl)phenethyl)-3-(2-(3-(4-phenylpiperazin-1-yl)propoxy)ethyl)isoxazole
3-((2-(4-phenylpiperazin-1-yl)ethoxy)methyl)isoxazole
3-((2-(3-phenoxypropoxy)ethoxy)methyl)isoxazole
(1r,3r)-3-phenoxycyclobutan-1-amine
3-([1,1′-biphenyl]-3-yloxy)propan-1-ol
6-(4-(2-(isoxazol-3-yl)ethyl)piperazin-1-yl)nicotinaldehyde
5-(4-aminobutoxy)picolinaldehyde
4-(4-(8-(2-oxoethyl)-3,8-diazabicyclo[3.2.1]octan-3-yl)butyl)benzaldehyde
2-(4-((4-(5-(hydroxymethyl)pyridin-2-yl)piperazin-1-yl)methyl)piperidin-1-yl)acetaldehyde
6-(4-((1-(2-oxoethyl)piperidin-4-yl)methyl)piperazin-1-yl)nicotinaldehyde
6-(3-(2-(4-(2-oxoethyl)piperazin-1-yl)ethyl)pyrrolidin-1-yl)nicotinaldehyde
(R)-4-(3-(2-(hydroxymethyl)-4-(2-oxoethyl)piperazin-1-yl)propyl)benzaldehyde
2-((4-(3-aminophenoxy)benzyl)oxy)acetaldehyde
2-(3-(3-(4-amino-2-fluorophenoxy)propoxy)propoxy)acetaldehyde
2-(2-(2-(4-(4-aminophenoxy)butoxy)ethoxy)ethoxy)acetaldehyde
(1r,3R)-3-ethoxy-N-isopropyl-N-(((1r,4R)-4-methylcyclohexyl)methyl)cyclobutan-1-amine
N-methyl-2-(6-methylbenzofuran-2-yl)ethan-1-amine
3-(1-(2-(2-(methylamino)ethoxy)ethyl)-1H-pyrazol-3-yl)-N-(3-((3-methylbenzyl)oxy)propyl)propan-1-amine
N-methyl-3-((3-methylbenzyl)oxy)propan-1-amine
(1s,3s)-N-methyl-3-(m-tolyloxy)cyclobutan-1-amine
4-(((1r,4r)-4-(1H-pyrazol-3-yl)cyclohexyl)oxy)-2-methylbenzonitrile
(1r,3r)-N-methyl-3-(m-tolyloxy)cyclobutan-1-amine
N-(3-(2-((1r,3r)-3-(methylamino)cyclobutoxy)pyridin-4-yl)propyl)-1-(p-tolyl)pyrrolidin-3-amine
(S)—N-methyl-1-(p-tolyl)pyrrolidin-3-amine
(R)—N-methyl-1-(p-tolyl)pyrrolidin-3-amine
(R)—N-methyl-1-(6-methylpyridin-3-yl)pyrrolidin-3-amine
N-methyl-4-(p-tolyl)butan-1-amine
N-methyl-2-(p-tolyloxy)ethan-1-amine
N-methyl-2-((6-methylpyridin-3-yl)oxy)ethan-1-amine
(1s,3s)-N-methyl-3-(p-tolyloxy)cyclobutan-1-amine
(1r,3r)-N-methyl-3-(p-tolyloxy)cyclobutan-1-amine
(4-methylpiperazin-1-yl)(m-tolyl)methanone
1-(2-(4-(5-acetylpyridin-2-yl)piperazin-1-yl)ethoxy)propan-2-one
2-(3-ethylphenoxy)-N-methylethan-1-amine
(1s,3s)-3-(3-ethylphenoxy)-N-methylcyclobutan-1-amine
(1s,3s)-3-((4-ethylpyridin-2-yl)oxy)-N-methylcyclobutan-1-amine
(1r,3r)-3-(3-ethylphenoxy)-N-methylcyclobutan-1-amine
(1r,3r)-3-((4-ethylpyridin-2-yl)oxy)-N-methylcyclobutan-1-amine
2-((5-ethylpyridin-2-yl)oxy)-N-methylethan-1-amine
(1s,3s)-3-((5-ethylpyridin-2-yl)oxy)-N-methylcyclobutan-1-amine
(1r,3r)-3-((5-ethylpyridin-2-yl)oxy)-N-methylcyclobutan-1-amine
4-ethyl-2-(4-methylpiperazin-1-yl)pyrimidine
1-(4-methylpiperazin-1-yl)pentan-1-one
N-methyloctan-1-amine
N-methylhexan-1-amine
3-butoxy-N-methylpropan-1-amine
4-(4-(propoxycarbonyl)phenyl)piperazine-1-carboxylic acid
N-methyl-2-propoxyethan-1-amine
2-((1-ethylpiperidin-4-yl)oxy)-N-methylethan-1-amine
3-(4-ethylpiperazin-1-yl)-N-methylpropan-1-amine
2-(4-ethylpiperazin-1-yl)-N-methylethan-1-amine
1-(2-ethoxyethyl)-4-methylpiperazine
2-(2-ethoxyethoxy)-N-methylethan-1-amine
3-(3-(3-cyclobutoxy-2,2-difluoropropoxy)propoxy)-1-methylazetidine
3-(3-(3-(313-cyclobutoxy)-2,2-difluoropropoxy)propoxy)-1-methylazetidine
3-((3-(2-((1-methylazetidin-3-yl)oxy)ethoxy)cyclobutyl)methoxy)cyclobutan-1-ol
1-((1-methylazetidin-3-yl)methyl)-4-(p-tolyl)piperazine
(4-methylpiperazin-1-yl)(1-(4-(4-(1-methylpiperidin-4-yl)piperazin-1-yl)butyl)piperidin-4-yl)methanone
1-methyl-4-(1-methylpiperidin-4-yl)piperazine
1-(1-methylpiperidin-4-yl)piperazine
(1R,3r)-N-methyl-3-((1-(4-(((1s,3S)-3-((1-methylpiperidin-4-yl)oxy)cyclobutyl)amino)butyl)piperidin-4-yl)oxy)cyclobutan-1-amine
(1s,3s)-N-methyl-3-((1-methylpiperidin-4-yl)oxy)cyclobutan-1-amine
(1r,3r)-N-methyl-3-((1-methylpiperidin-4-yl)oxy)cyclobutan-1-amine
1-((3S)-1,3-dimethylpiperidin-4-yl)piperazine
1-((3R)-1,3-dimethylpiperidin-4-yl)piperazine
1-methyl-4-(2-methyl-4-((2-phenylpropan-2-yl)oxy)butan-2-yl)piperazine
1-((2R,5S)-1,2,5-trimethylpiperidin-4-yl)piperazine
2-(2-(2-(4-(4-(methylamino)phenoxy)butoxy)ethoxy)ethoxy)acetaldehyde
2-(2-(2-(2-(4-(methylamino)phenoxy)ethoxy)ethoxy)ethoxy)acetaldehyde
2-(4-(2-(2-((1S,4S)-5-(2-(2-(methylamino)ethoxy)ethyl)-2,5-diazabicyclo[2.2.1]heptan-2-yl)ethoxy)ethyl)piperazin-1-yl)ethan-1-ol
2-(3-fluoro-5-((1s,3s)-3-(methylamino)cyclobutoxy)phenoxy)acetaldehyde
(R)-(2-methoxyphenyl)(3-(methylamino)pyrrolidin-1-yl)methanone
N-(3-(2-methoxyphenoxy)propyl)-4-(3-(2-(methylamino)ethoxy)phenoxy)butan-1-amine
3-(2-methoxyphenoxy)-N-methylpropan-1-amine
1-(4-methoxypyridin-2-yl)-4-methylpiperazine
2-(3-methoxyphenoxy)-N-methylethan-1-amine
(1s,3s)-3-(3-methoxyphenoxy)-N-methylcyclobutan-1-amine
(1s,3s)-3-((4-methoxypyridin-2-yl)oxy)-N-methylcyclobutan-1-amine
2-((4-methoxyphenyl)sulfonyl)-N-methylethan-1-amine
1-(5-methoxypyridin-2-yl)-N-methylazetidin-3-amine
2-((5-methoxypyridin-2-yl)oxy)-N-methylethan-1-amine
(1s,3s)-3-((5-methoxypyridin-2-yl)oxy)-N-methylcyclobutan-1-amine
(1r,3r)-3-((5-methoxypyridin-2-yl)oxy)-N-methylcyclobutan-1-amine
4-methoxy-2-(4-methylpiperazin-1-yl)pyrimidine
6-(3-hydroxy-3-methylbut-1-yn-1-yl)-4-(4-(3-methoxycyclobutoxy)piperidin-1-yl)nicotinonitrile
2-((6-(4-(3-methoxycyclobutoxy)piperidin-1-yl)pyridazin-4-yl)oxy)ethan-1-ol
4-methoxy-1-(2-(p-tolyloxy)ethyl)piperidine
5-(4-((1-(5-(methoxycarbonyl)pyridin-2-yl)piperidin-4-yl)methyl)piperazin-1-yl)picolinic acid
methyl 4-(4-carbamoylphenyl)piperazine-1-carboxylate
methyl 4-(2-(4-(benzyloxy)phenoxy)ethyl)piperazine-1-carboxylate
methyl 4-(2-(4-hydroxyphenoxy)ethyl)piperazine-1-carboxylate
(Z)-4-(4-(4-methoxy-4-oxobut-2-en-2-yl)phenyl)piperazine-1-carboxylic acid
3-(4-(methoxymethyl)phenoxy)-N-methylaniline
3-((1-(3-(3-methoxyprop-1-yn-1-yl)-5-(trifluoromethyl)phenyl)piperidin-4-yl)oxy)cyclobutan-1-ol
1-(4-(5-methoxypenta-1,3-diyn-1-yl)phenyl)ethan-1-amine
N-(4-(2-methoxyethyl)benzyl)-5-(3-(2-(methylamino)ethoxy)phenyl)pentan-1-amine
1-(4-(2-methoxyethyl)phenyl)-N-methylmethanamine
3-methoxy-1-(4-(4-((methylamino)methyl)phenyl)piperazin-1-yl)propan-1-one
(R)-3-methoxy-1-(3-(methylamino)pyrrolidin-1-yl)propan-1-one
N-(2-((4-(aminomethyl)phenyl)amino)ethyl)-3-methoxypropanamide
3-methoxy-1-((R)-3-(methylamino)pyrrolidin-1-yl)propan-1-ol
3-((5-(6-methoxyhex-1-yn-1-yl)pyridin-2-yl)oxy)propan-1-ol
2-(3-ethoxypropoxy)-5-(6-methoxyhex-1-yn-1-yl)pyridine
4-methoxy-N-methylbutan-1-amine
3-methoxy-N-methylpropan-1-amine
6-(4-(3-methoxypropoxy)cyclohexa-1,3-dien-1-yl)-N-methylpyridin-3-amine
5-(4-(3-methoxypropoxy)cyclohexa-1,3-dien-1-yl)-N-methylpyrazin-2-amine
2-(3-(azetidin-3-yloxy)propyl)-5-(3-methoxypropoxy)pyridine
2-(3-(azetidin-3-yloxy)prop-1-yn-1-yl)-5-(3-methoxypropoxy)pyridine
3-(3-methoxypropoxy)-1-methylazetidine
5-(3-methoxypropoxy)-N-methylpentan-1-amine
3-(3-methoxypropoxy)-N-methylpropan-1-amine
2-(3-methoxypropoxy)-N-methylethan-1-amine
2-((3-methoxypropyl)sulfonyl)-N-methylethan-1-amine
2-((3-methoxypropyl)sulfinyl)-N-methylethan-1-amine
2-((3-methoxypropyl)thio)-N-methylethan-1-amine
1-(4-(1-(2-methoxyethyl)piperidin-4-yl)phenyl)-N-methylmethanamine
1-(2-methoxyethyl)-N-methylpiperidin-4-amine
1-(4-(4-(2-methoxyethyl)piperazin-1-yl)phenyl)-N-methylmethanamine
2-(4-(2-(2-((1S,4S)-5-(2-methoxyethyl)-2,5-diazabicyclo[2.2.1]heptan-2-yl)ethoxy)ethyl)piperazin-1-yl)ethan-1-ol
3-(2-methoxyethoxy)-N-methylpropan-1-amine
4-(2-(2-methoxyethoxy)ethoxy)-N-methylbutan-1-amine
N-methyl-2,5,8,12,15-pentaoxaheptadecan-17-amine
2-(2-(2-methoxyethoxy)ethoxy)-N-methylethan-1-amine
N-methyl-2,5,8,11-tetraoxatridecan-13-amine
(1s,3s)-3-(2-methoxyethoxy)-N-methylcyclobutan-1-amine
(1r,3r)-3-(2-methoxyethoxy)-N-methylcyclobutan-1-amine
2-((1r,3r)-3-(2-methoxyethoxy)cyclobutoxy)-N-methylethan-1-amine
(S)-1-methoxy-3-(4-(3-(4-(4-methoxypyrimidin-2-yl)piperazin-1-yl)propyl)piperazin-1-yl)propan-2-ol
(S)-1-methoxy-3-(4-methylpiperazin-1-yl)propan-2-ol
(R)-1-methoxy-3-(4-methylpiperazin-1-yl)propan-2-ol
(Z)-2-((4-methoxybut-2-en-1-yl)oxy)-N-methylethan-1-amine
1-(4-methylpyridin-2-yl)piperazine
5-(2-(4-(4-(isoxazol-3-yl)butyl)piperazin-1-yl)ethyl)-3-(3-(piperazin-1-yl)propyl)isoxazole
1-phenyl-4-(2-(piperazin-1-yl)ethyl)piperazine
2-(3-(3-(4-(1-aminocyclopropyl)phenoxy)propoxy)propoxy)acetaldehyde
2-(4-(3-(4-aminophenoxy)propoxy)butoxy)acetaldehyde
2-(3-(4-(3-(4-aminophenoxy)propoxy)butoxy)propoxy)acetaldehyde
2-(3-(3-(4-amino-2-fluorophenoxy)propoxy)propoxy)acetaldehyde
2-(3-(3-(4-amino-3-fluorophenoxy)propoxy)propoxy)acetaldehyde
14-(4-aminophenoxy)-3,6,9,12-tetraoxatetradecanal
1-(4-methylpyridin-2-yl)pyrrolidin-3-amine
1-(2-methoxyethyl)piperidin-4-amine
1-(4-methylpyridin-2-yl)azetidin-3-amine
2-(4-(4-phenoxybutyl)piperazin-1-yl)acetamide
N-(2-(4-(4-(2-amino-2-oxoethyl)piperazin-1-yl)butoxy)ethyl)-2-(4-(3-hydroxypropyl)piperazin-1-yl)acetamide
2-((5-(2-(piperazin-1-yl)ethoxy)pentyl)oxy)acetamide
4-(4-(2-carbamoylhydrazine-1-carbonyl)phenyl)piperazine-1-carboxylic acid
3,3-difluoro-5-methoxypentan-1-amine
9-(3-((5-(methylamino)pentyl)oxy)propoxy)nonan-1-amine
5-methoxypentan-1-amine
4-((6-methylpyridin-3-yl)oxy)butan-1-amine3-((2-methylbenzofuran-5-yl)oxy)propan-1-amine
6-(3-aminopropoxy)-2-methyl-N-(3-(2-(methylamino)ethoxy)benzyl)imidazo[1,2-a]pyridin-8-amine
3-((2-methylimidazo[1,2-a]pyridin-6-yl)oxy)propan-1-amine
3-((6-methylpyridin-3-yl)oxy)propan-1-amine
2-((2-methylbenzofuran-5-yl)oxy)ethan-1-amine
2-(m-tolyloxy)ethan-1-amine
3-(6-(2-aminoethoxy)pyridin-2-yl)-N-(2-((2-methylbenzofuran-5-yl)oxy)ethyl)propan-1-amine
(E)-2-(3-(prop-1-en-1-yl)phenoxy)ethan-1-amine
3-(6-(2-aminoethoxy)imidazo[1,2-a]pyridin-2-yl)-N-(3-((2-methylimidazo[1,2-a]pyridin-6-yl)oxy)propyl)propan-1-amine
2-((2-methylimidazo[1,2-a]pyridin-6-yl)oxy)ethan-1-amine
2-(2-(3-methyl-1H-pyrazol-1-yl)ethoxy)ethan-1-amine
2-(4-(2-(2-((1S,4S)-5-(2-(2-aminoethoxy)ethyl)-2,5-diazabicyclo[2.2.1]heptan-2-yl)ethoxy)ethyl)piperazin-1-yl)ethan-1-ol
2,5,8,13,16-pentaoxaoctadecan-18-amine
2,5,8,12,15-pentaoxaheptadecan-17-amine
2,5,8,11,14,17-hexaoxanonadecan-19-amine
2,5,8,11,14-pentaoxahexadecan-16-amine
2,5,8,11-tetraoxatridecan-13-amine
2-(2-(2-methoxyethoxy)ethoxy)ethan-1-amine
2-(2-methoxyethoxy)ethan-1-amine
(S)-1-(2-methoxyethyl)pyrrolidin-3-amine
(1r,3r)-3-((2-methylbenzofuran-6-yl)oxy)cyclobutan-1-amine
(1r,3r)-3-((2-methylbenzofuran-5-yl)oxy)cyclobutan-1-amine
(1r,3r)-3-(p-tolyloxy)cyclobutan-1-amine
(1r,3r)-3-((5-methylpyridin-2-yl)oxy)cyclobutan-1-amine
(1r,3r)-3-(m-tolyloxy)cyclobutan-1-amine
(1r,3r)-3-((5-methylpyrazin-2-yl)oxy)cyclobutan-1-amine
(1r,3r)-3-((4-methylpyridin-2-yl)oxy)cyclobutan-1-amine
(1s,3s)-3-((2-(3-(6-((1s,3s)-3-aminocyclobutoxy)benzofuran-2-yl)propyl)benzofuran-5-yl)oxy)-N-methylcyclobutan-1-amine
(1s,3s)-3-((2-methylbenzofuran-6-yl)oxy)cyclobutan-1-amine
(1s,3s)-3-((2-methylbenzofuran-5-yl)oxy)cyclobutan-1-amine
(1s,3s)-3-(m-tolyloxy)cyclobutan-1-amine
(1s,3s)-3-((2-methylpyridin-4-yl)oxy)cyclobutan-1-amine
(1s,3s)-3-((5-methoxypyridin-2-yl)oxy)cyclobutan-1-amine
(1s,3s)-3-((4-methylpyridin-2-yl)oxy)cyclobutan-1-amine(1s,3s)-3-(2-methoxyethoxy)cyclobutan-1-amine
(R)-2-(3-(3-(4-(1-aminoethyl)phenoxy)propoxy)propoxy)acetaldehyde
6-(5-hydroxy-2,2,4,4-tetramethylpentyl)pyridin-3-ol
4-(2-(6-hydroxypyridin-3-yl)-1,3-dioxoisoindolin-5-yl)piperazine-1-carboxylic acid
3-(2-((2-(2-((1-methylazetidin-3-yl)oxy)ethoxy)ethoxy)methyl)cyclopropyl)cyclobutan-1-ol
3-((6-(3-(2-hydroxyethoxy)-3-methylbut-1-yn-1-yl)pyridin-3-yl)oxy)cyclobutan-1-ol
3-((6-(3-(2-hydroxyethoxy)but-1-yn-1-yl)pyridin-3-yl)oxy)cyclobutan-1-ol
3-((6-(3,3-difluoro-3-(2-hydroxyethoxy)prop-1-yn-1-yl)pyridin-3-yl)oxy)cyclobutan-1-ol
5-(3-hydroxycyclobutoxy)-2-(3-(2-hydroxyethoxy)-3-methylbut-1-yn-1-yl)isonicotinonitrile
3-((6-(3-(4-methylpiperazin-1-yl)propyl)pyridin-3-yl)oxy)cyclobutan-1-ol
3-((6-(3-(4-methylpiperazin-1-yl)propyl)pyridin-3-yl)oxy)cyclobutan-1-ol
3-((1-(5-(3-hydroxyprop-1-yn-1-yl)-2-methylphenyl)piperidin-4-yl)oxy)cyclobutan-1-ol
4-(4-(3-hydroxycyclobutoxy)piperidin-1-yl)-6-(3-hydroxyprop-1-yn-1-yl)nicotinonitrile
3-((1-(3-(3-hydroxyprop-1-yn-1-yl)-5-methylphenyl)piperidin-4-yl)oxy)cyclobutan-1-ol
3-((1-(3-(3-hydroxy-3-methylbut-1-yn-1-yl)phenyl)piperidin-4-yl)oxy)cyclobutan-1-ol
3-((1-(2-(3-hydroxy-3-methylbut-1-yn-1-yl)pyridin-4-yl)piperidin-4-yl)oxy)cyclobutan-1-ol
3-((1-(2-(3-hydroxy-3-methylbut-1-yn-1-yl)pyrimidin-4-yl)piperidin-4-yl)oxy)cyclobutan-1-ol
3-((1-(2,2-difluoro-5-methoxypentyl)piperidin-4-yl)oxy)cyclobutan-1-ol
3-((1-(2,2-difluoro-5-hydroxypentyl)piperidin-4-yl)oxy)cyclobutan-1-ol
3-((3-((3-(azetidin-3-yloxy)propoxy)methyl)oxetan-3-yl)methoxy)cyclobutan-1-ol
3-((3-(2-((1-methylazetidin-3-yl)oxy)ethoxy)cyclobutyl)methoxy)cyclobutan-1-ol
3-((3-((2-((1-ethylazetidin-3-yl)oxy)ethoxy)methyl)bicyclo[1.1.1]pentan-1-yl)methoxy)cyclobutan-1-ol
3-((3-((2-((1-methylazetidin-3-yl)oxy)ethoxy)methyl)bicyclo[1.1.1]pentan-1-yl)methoxy)cyclobutan-1-ol
3-(3-(3-((1-ethylazetidin-3-yl)oxy)-2,2-difluoropropoxy)propoxy)cyclobutan-1-ol
3-(3-(2,2-difluoro-3-((1-methylazetidin-3-yl)oxy)propoxy)propoxy)cyclobutan-1-ol
3-((3-(2-((1-methylazetidin-3-yl)oxy)ethoxy)cyclobutyl)methoxy)cyclobutan-1-ol
7-(piperazin-1-yl)decahydronaphthalen-2-ol
1-(3-(3-(3-(aminomethyl)phenyl)propoxy)propyl)piperidin-3-ol
4-(4-carboxyphenyl)piperazine-1-carboxylic acid
4-(6-carboxypyridin-3-yl)piperazine-1-carboxylic acid
5-(4-((1-(5-carboxypyridin-2-yl)piperidin-4-yl)methyl)piperazin-1-yl)picolinic acid
(S)-5-amino-4-(4-(3-((1-(4-(methoxycarbonyl)phenyl)piperidin-4-yl)methyl)azetidin-1-yl)-1-oxoisoindolin-2-yl)-5-oxopentanoic acid
2-((5-((4-(cyclopentylcarbamoyl)phenyl)amino)pentyl)oxy)acetic acid
4-(4-carboxyphenyl)piperazine-1-carboxylic acid
4-(4-((2-carboxyethyl)amino)-2-fluorobenzoyl)piperazine-1-carboxylic acid
3-((1-(2-(3,3-difluoro-3-hydroxyprop-1-yn-1-yl)pyridin-4-yl)piperidin-4-yl)oxy)cyclobutan-1-ol
3-(4-(3-hydroxycyclobutoxy)piperidin-1-yl)-5-(3-hydroxyprop-1-yn-1-yl)benzonitrile
3-((1-(2-(3-hydroxyprop-1-yn-1-yl)-6-(trifluoromethyl)pyridin-4-yl)piperidin-4-yl)oxy)cyclobutan-1-ol
3-((1-(3-(3-hydroxyprop-1-yn-1-yl)phenyl)piperidin-4-yl)oxy)cyclobutan-1-ol
1-((4-(3-(3-hydroxyprop-1-yn-1-yl)phenyl)piperazin-1-yl)methyl)cyclobutane-1,3-diol
3-((4-(3-(3-hydroxyprop-1-yn-1-yl)phenyl)piperazin-1-yl)methyl)cyclobutan-1-ol
3-((1-(2-(3-hydroxyprop-1-yn-1-yl)pyridin-4-yl)piperidin-4-yl)oxy)cyclobutan-1-ol
3-((1-(4-(3-hydroxyprop-1-yn-1-yl)-6-(trifluoromethyl)pyridin-2-yl)piperidin-4-yl)oxy)cyclobutan-1-ol
3-(3-(4-(3-ethoxycyclobutoxy)piperidin-1-yl)-4-(trifluoromethyl)phenyl)prop-2-yn-1-ol
2-(4-(3-hydroxycyclobutoxy)piperidin-1-yl)-4-(3-hydroxyprop-1-yn-1-yl)benzonitrile
3-((1-(5-(3-hydroxyprop-1-yn-1-yl)-2-(trifluoromethyl)phenyl)piperidin-4-yl)oxy)cyclobutan-1-ol
3-((1-(2-(3-hydroxyprop-1-yn-1-yl)-5-(trifluoromethyl)pyridin-4-yl)piperidin-4-yl)oxy)cyclobutan-1-ol
3-((1-(4-(3-hydroxyprop-1-yn-1-yl)pyrimidin-2-yl)piperidin-4-yl)oxy)cyclobutan-1-ol
3-((1-(3-(3-hydroxypropyl)phenyl)piperidin-4-yl)oxy)cyclobutan-1-ol
(3-hydroxyazetidin-1-yl)(3-(7-hydroxyheptyl)bicyclo[1.1.1]pentan-1-yl)methanone
(3-hydroxyazetidin-1-yl)(3-(((5-hydroxypentyl)oxy)methyl)bicyclo[1.1.1]pentan-1-yl)methanone
3-aminopropan-1-ol
3-((4′-(2-(3-(3-([1,1′-biphenyl]-4-yloxy)propoxy)propoxy)ethyl)-[1,1′-biphenyl]-3-yl)oxy)propan-1-ol
3-(4-(5-(2-(4-(3-(isoxazol-3-yl)propoxy)butoxy)ethyl)isoxazol-3-yl)butoxy)propan-1-ol
3-(2-(2-(phenoxymethyl)phenoxy)ethoxy)propan-1-ol
2-([1,4′-bipiperidin]-1′-yl)ethan-1-ol
2-(4-(2-(2-((1S,4S)-5-(2-hydroxyethyl)-2,5-diazabicyclo[2.2.1]heptan-2-yl)ethoxy)ethyl)piperazin-1-yl)ethan-1-ol
3-((6-((1-(2-hydroxyethoxy)cyclopropyl)ethynyl)pyridin-3-yl)oxy)cyclobutan-1-ol
3-((1-(2,2-difluoro-3-(2-hydroxyethoxy)propyl)piperidin-4-yl)oxy)cyclobutan-1-ol
2-(2-(3-(2-phenoxyethoxy)phenoxy)ethoxy)ethan-1-ol
2-(2-((5-(2-(2-((5-(isoxazol-3-yl)pentyl)oxy)ethoxy)ethyl)isoxazol-3-yl)methoxy)ethoxy)ethan-1-ol
2-(2-(2-(5-(2-(4-(isoxazol-3-yl)piperazin-1-yl)ethyl)isoxazol-3-yl)ethoxy)ethoxy)ethan-1-ol

In some embodiments, the linker L¹ in any of the formulae provided herein is selected from the groups listed below, wherein “R₁” represents the point of attachment to the LTM, e.g., to the X of one or more of R¹, R^{1b}, R^{2a}, R⁴, R^{5a}, R^{5b}, R⁶, R^{6a}, and R¹³; and “R₂” represents the point of attachment to the PTM. In some embodiments, the linker L¹ in any of the formulae provided herein is selected from the groups listed below, wherein “R₁” represents the point of attachment to the PTM, and “R₂” represents the point of attachment to the LTM, e.g., to the X of one or more of R¹, R^{1b}, R^{2a}, R⁴, R^{5a}, R^{5b}, R⁶, R^{6a}, or R¹³.

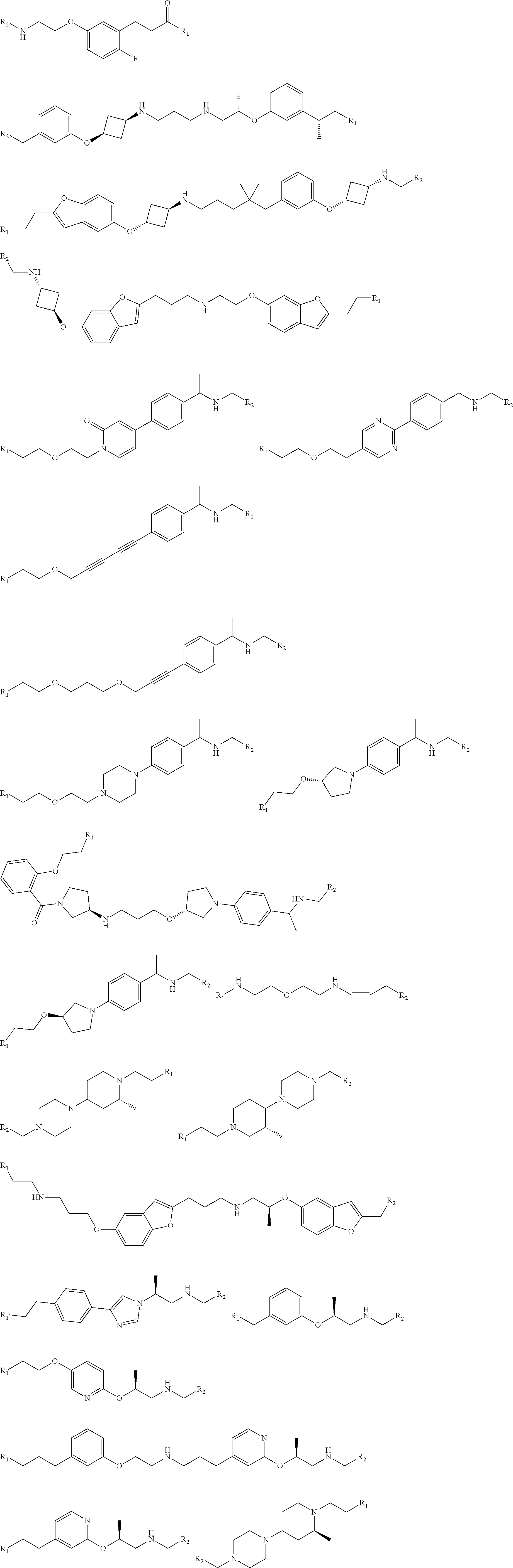

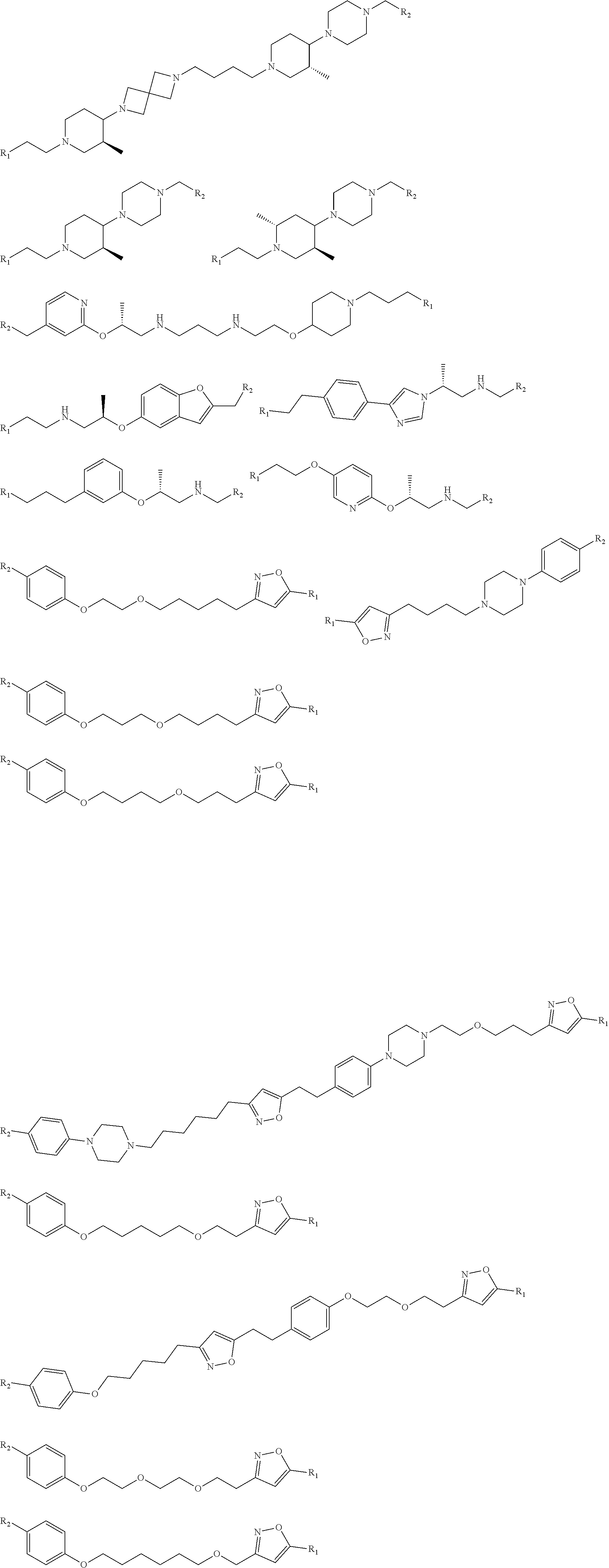

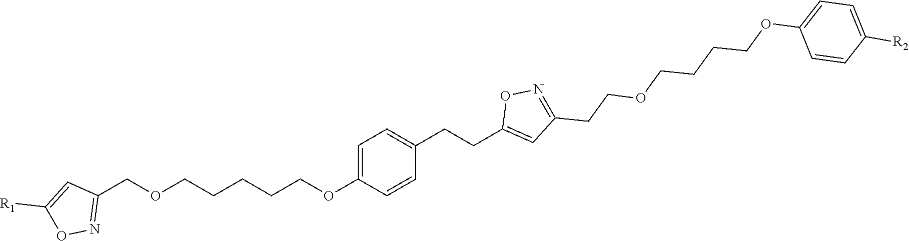

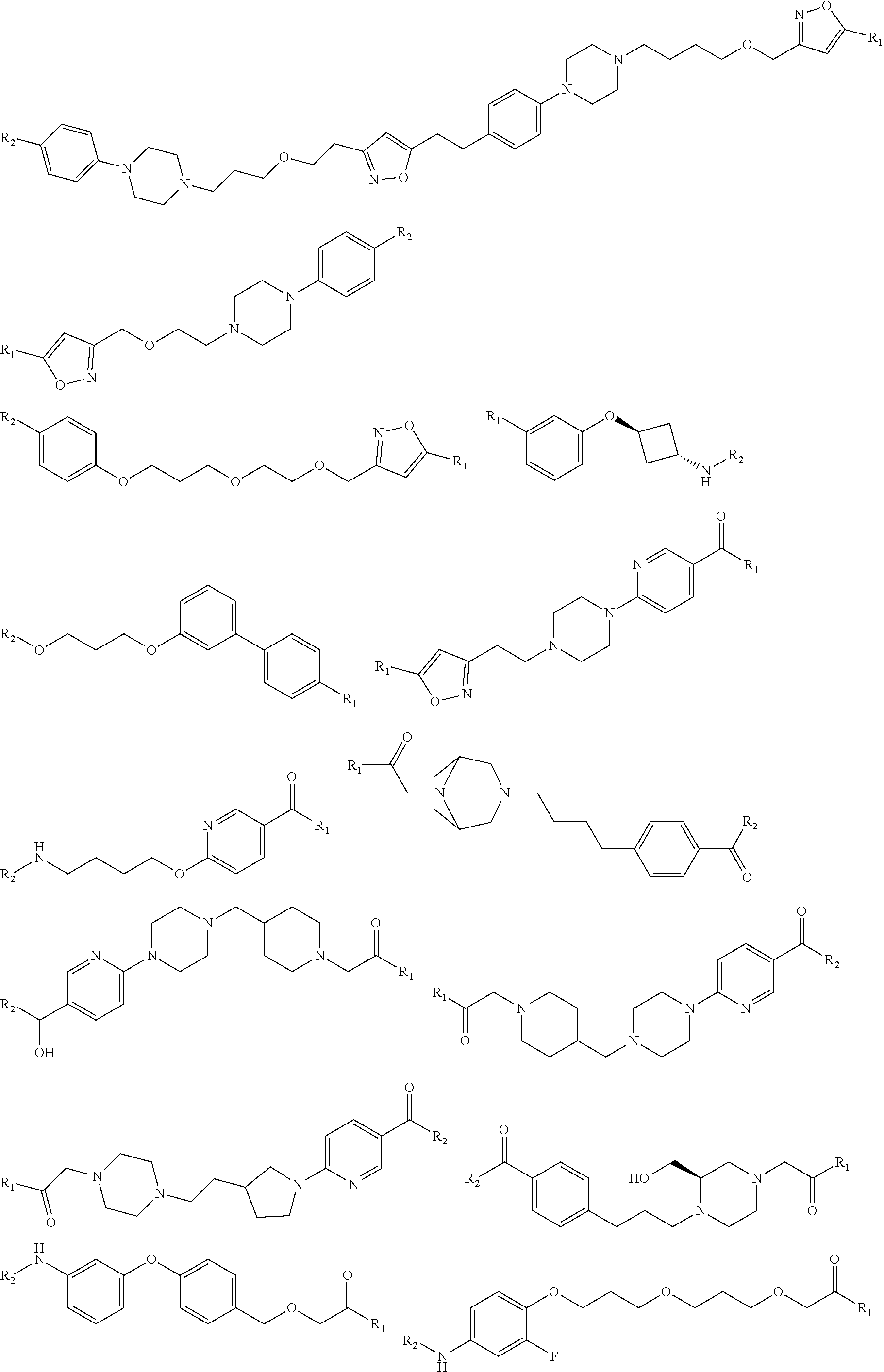

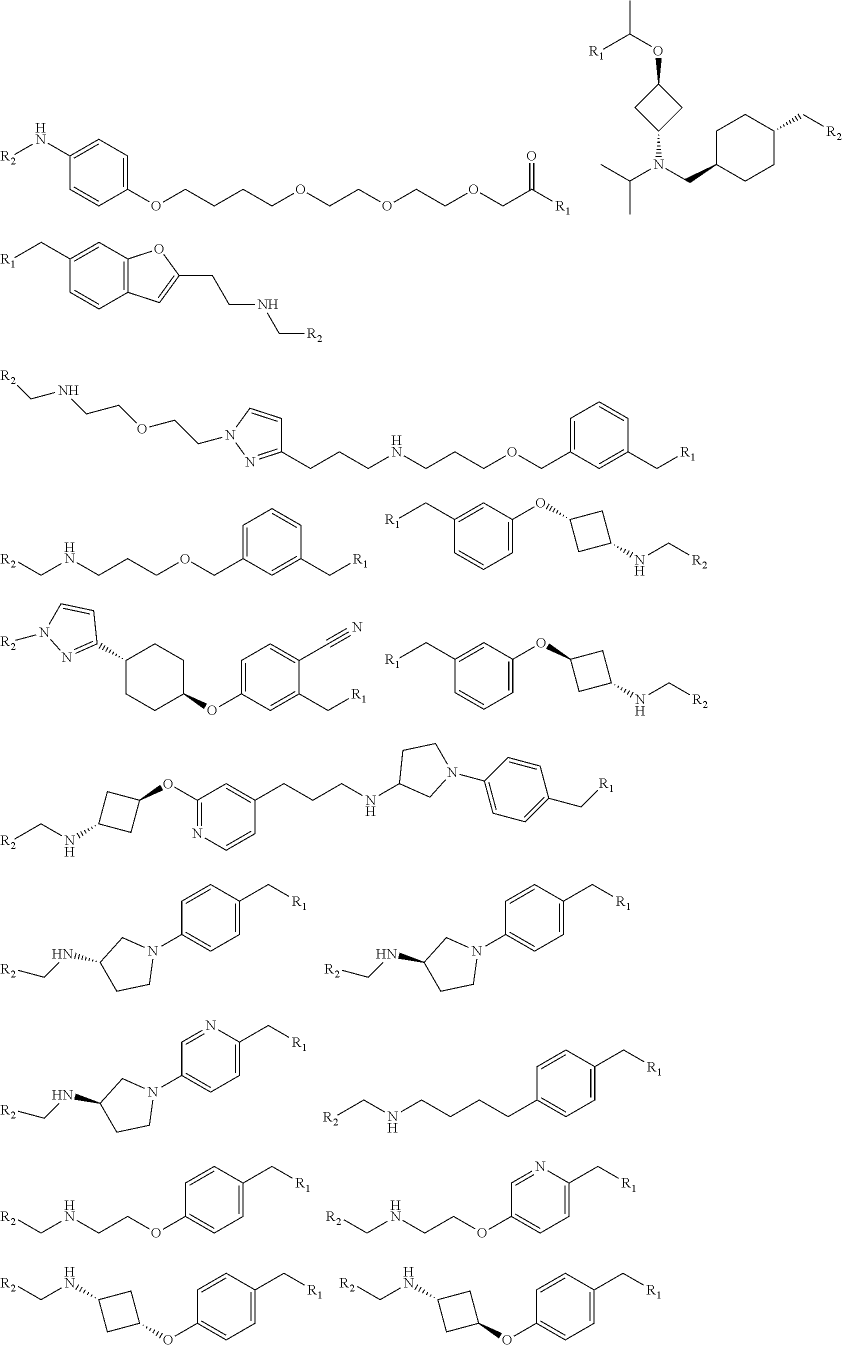

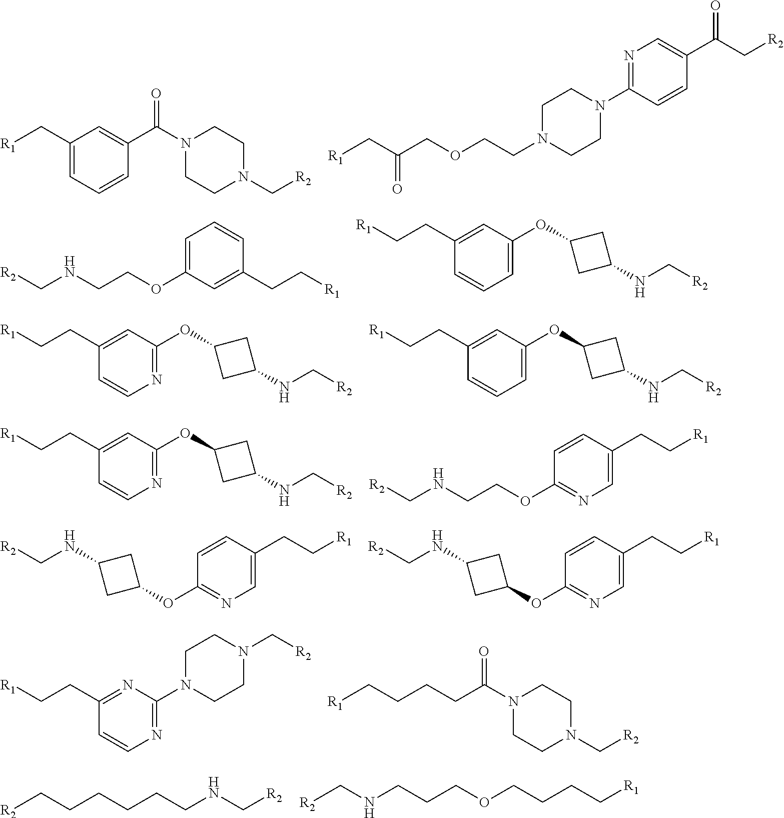

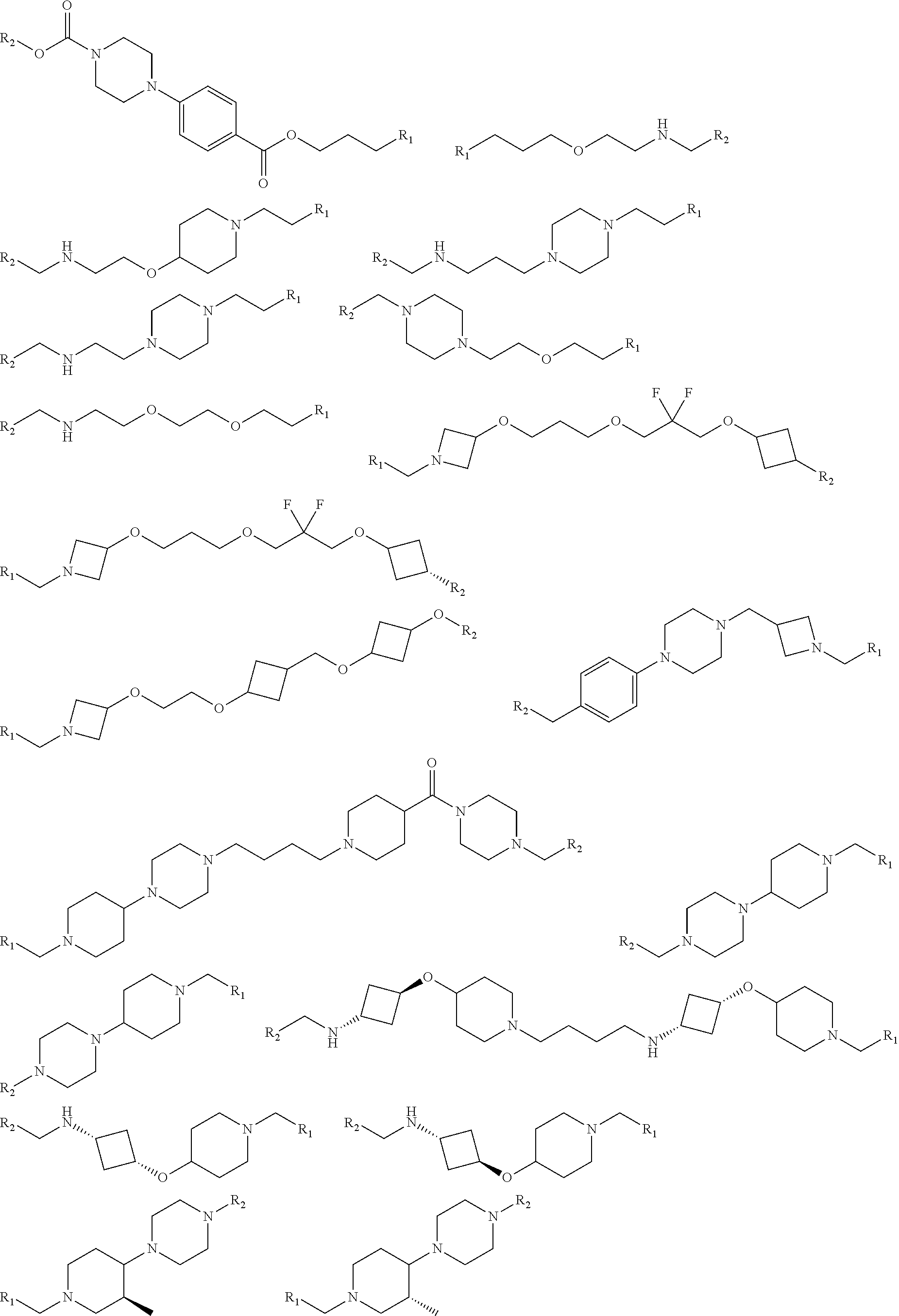

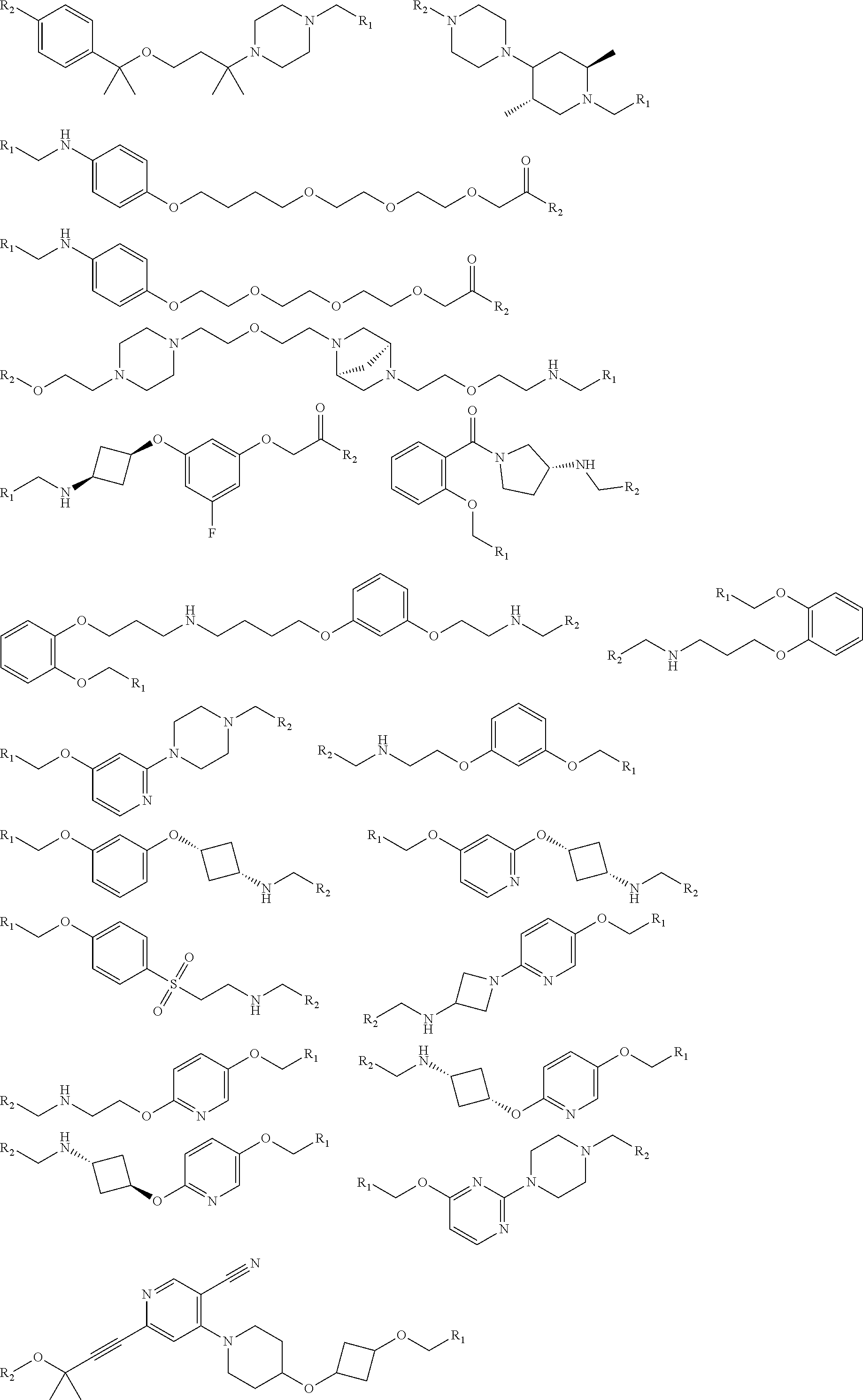

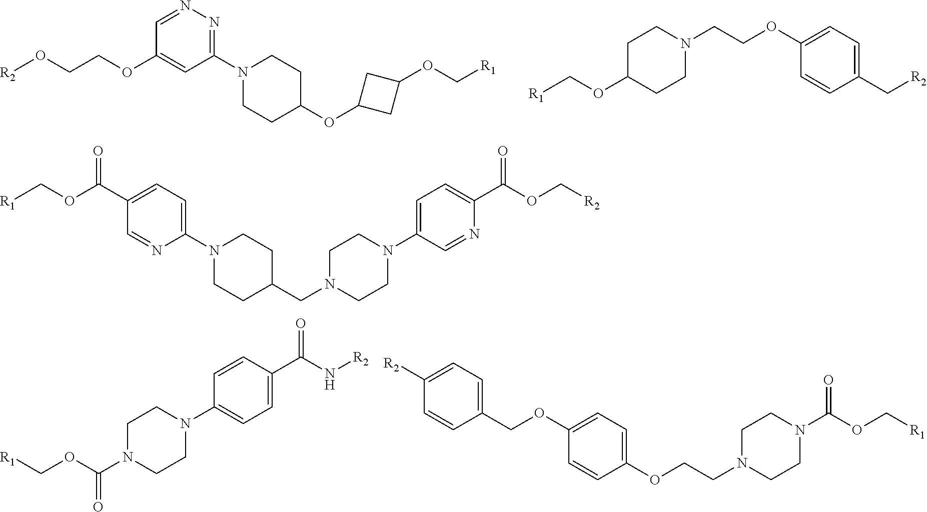

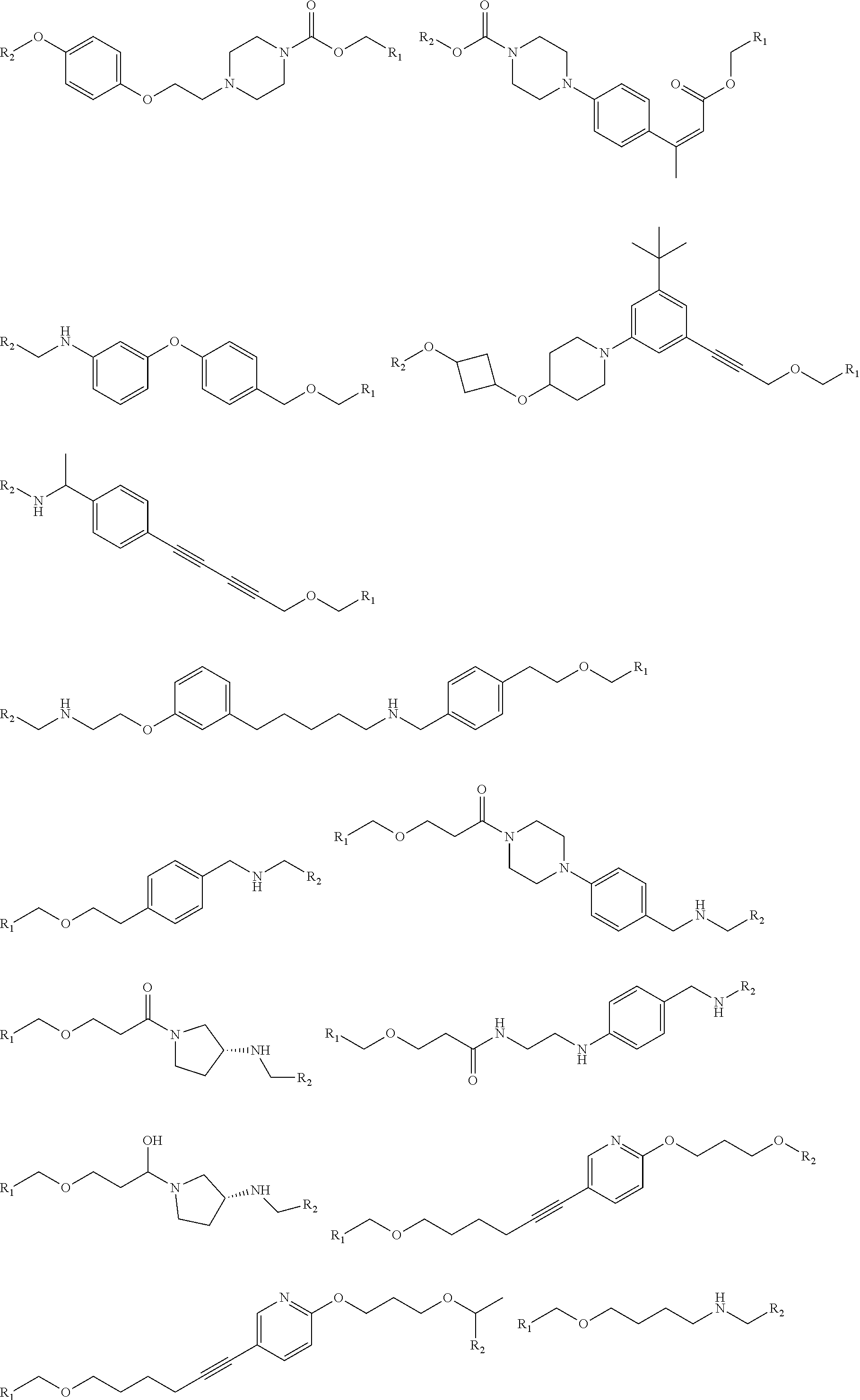

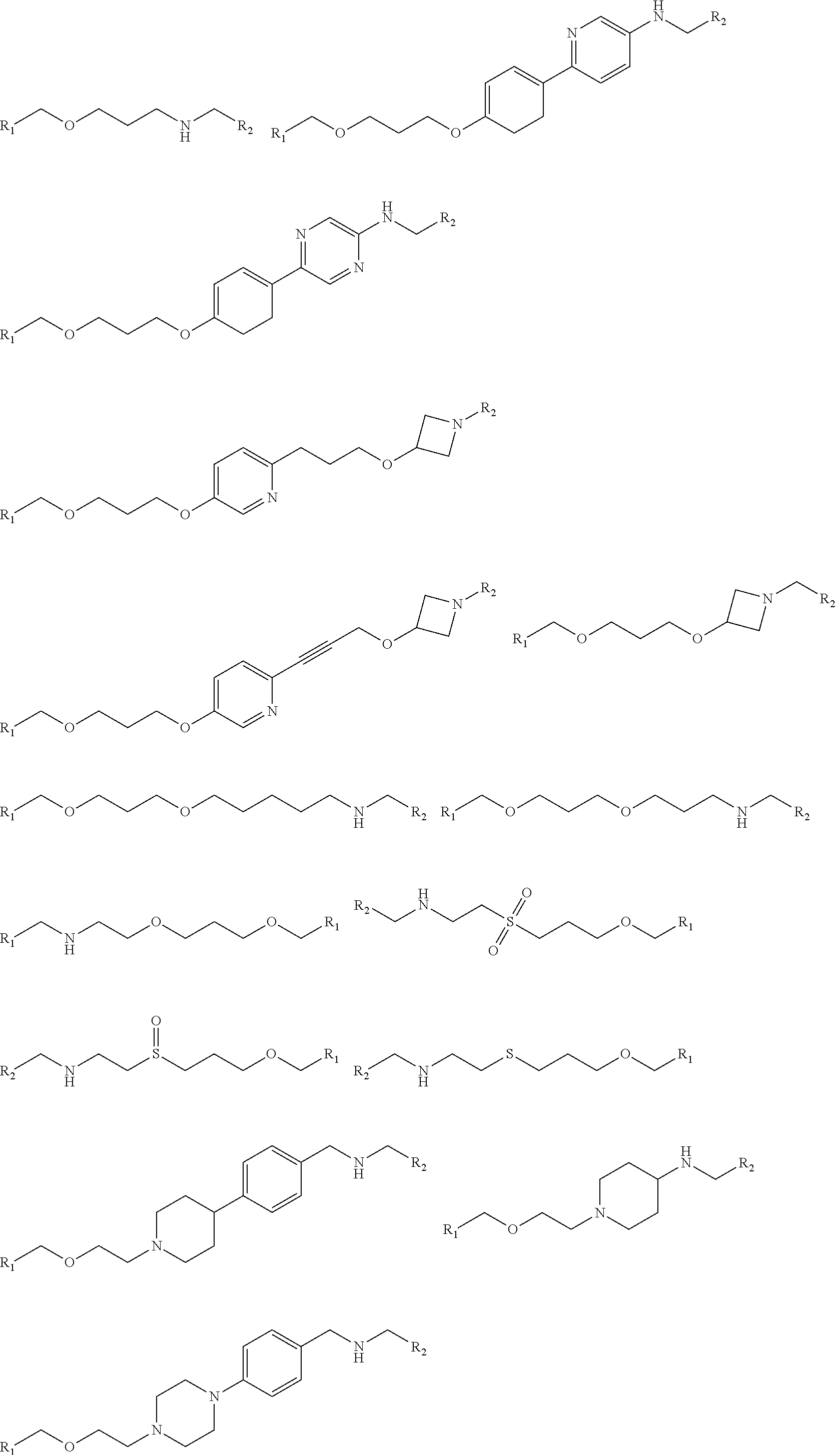

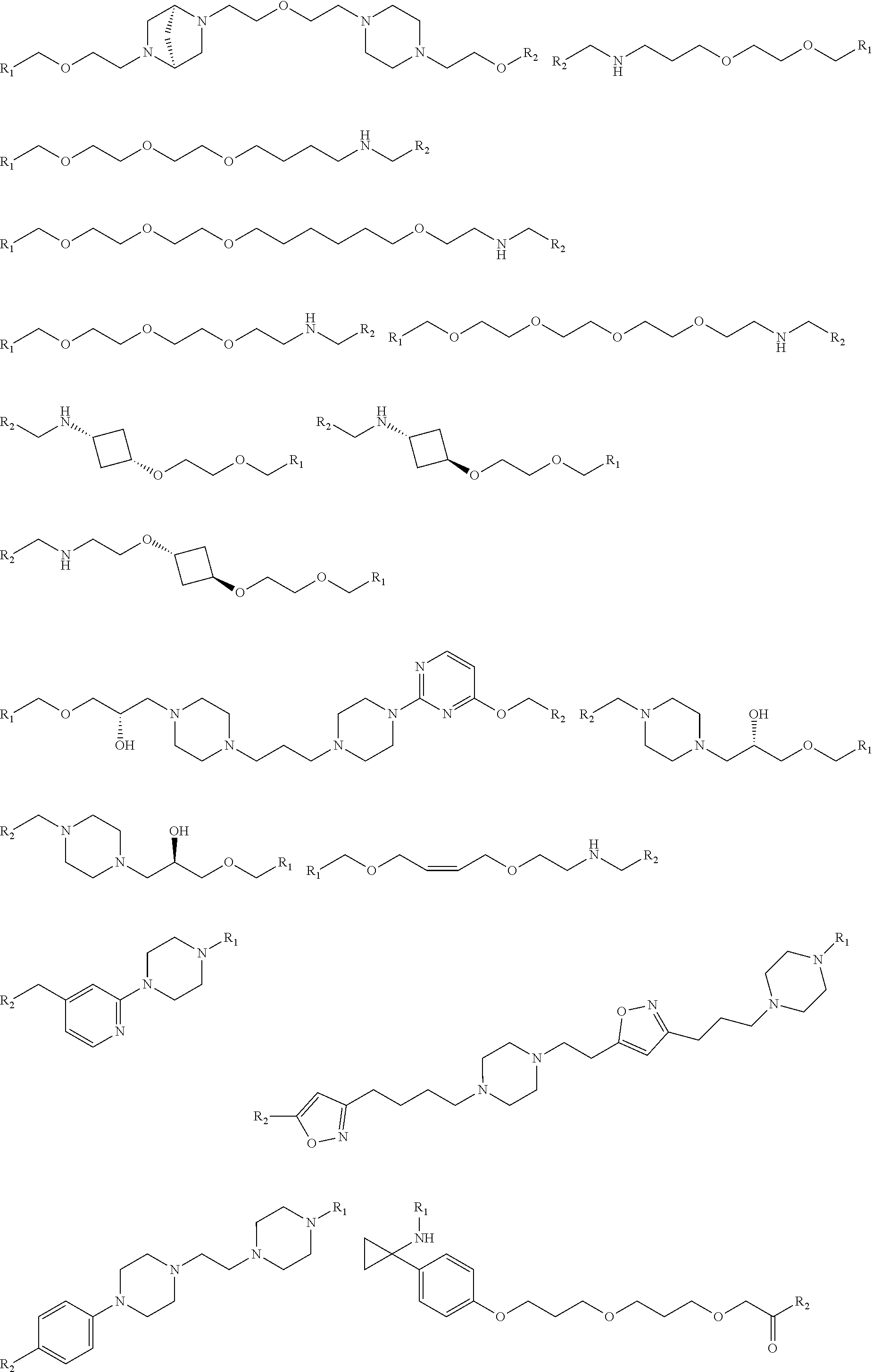

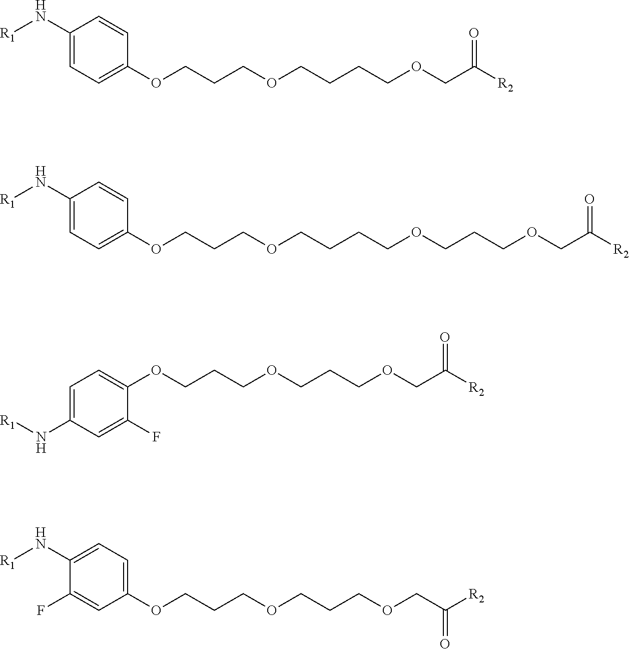

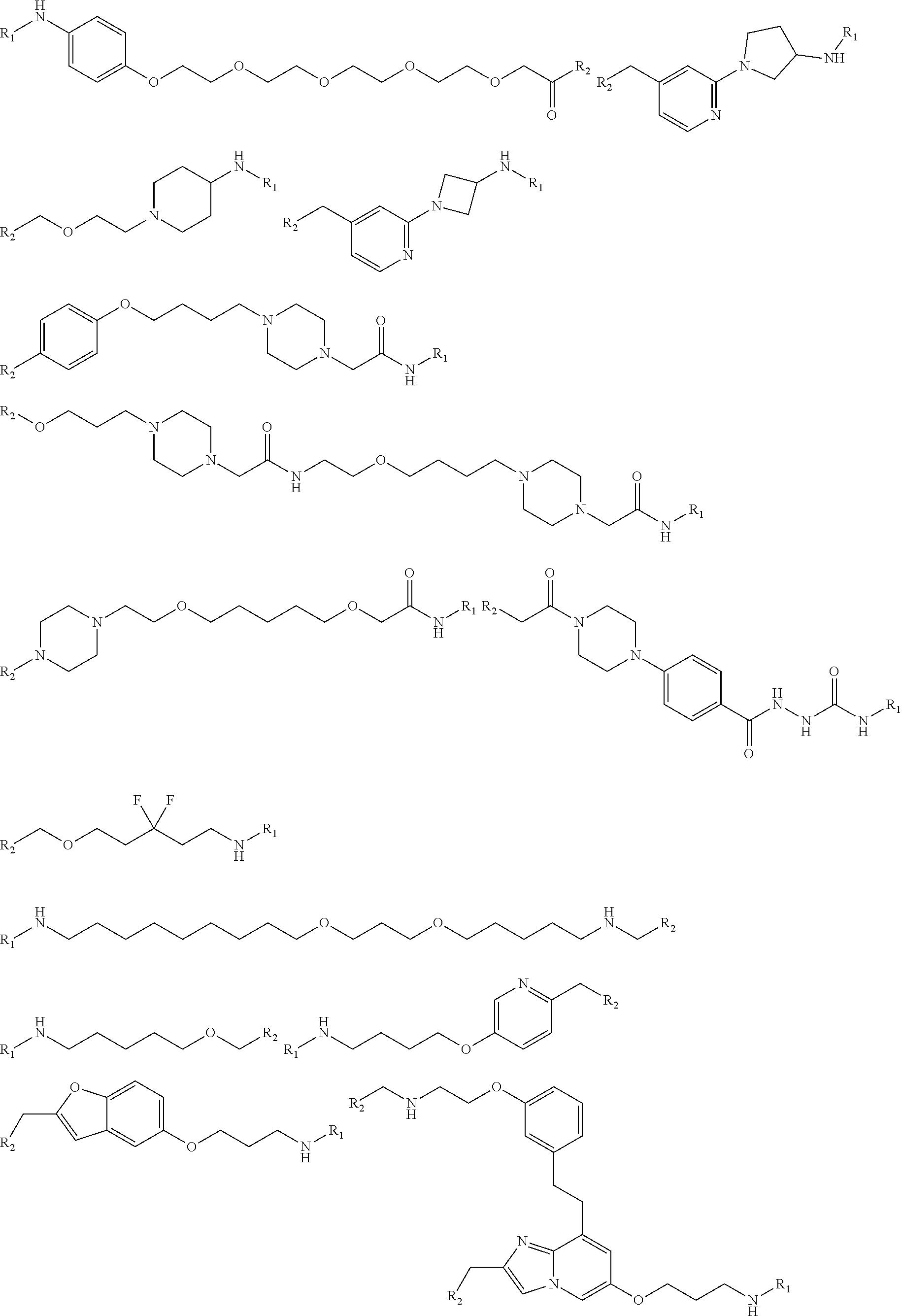

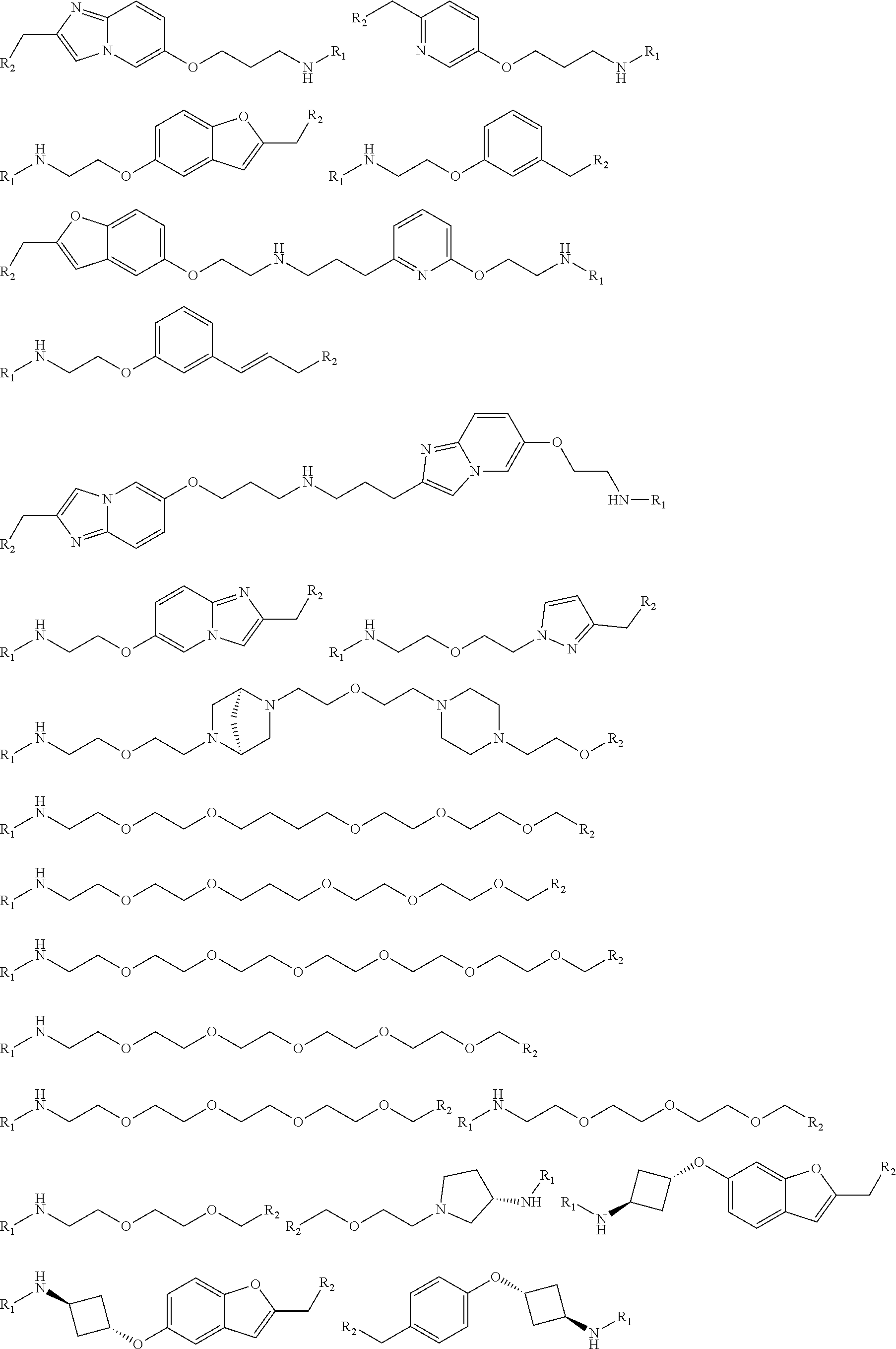

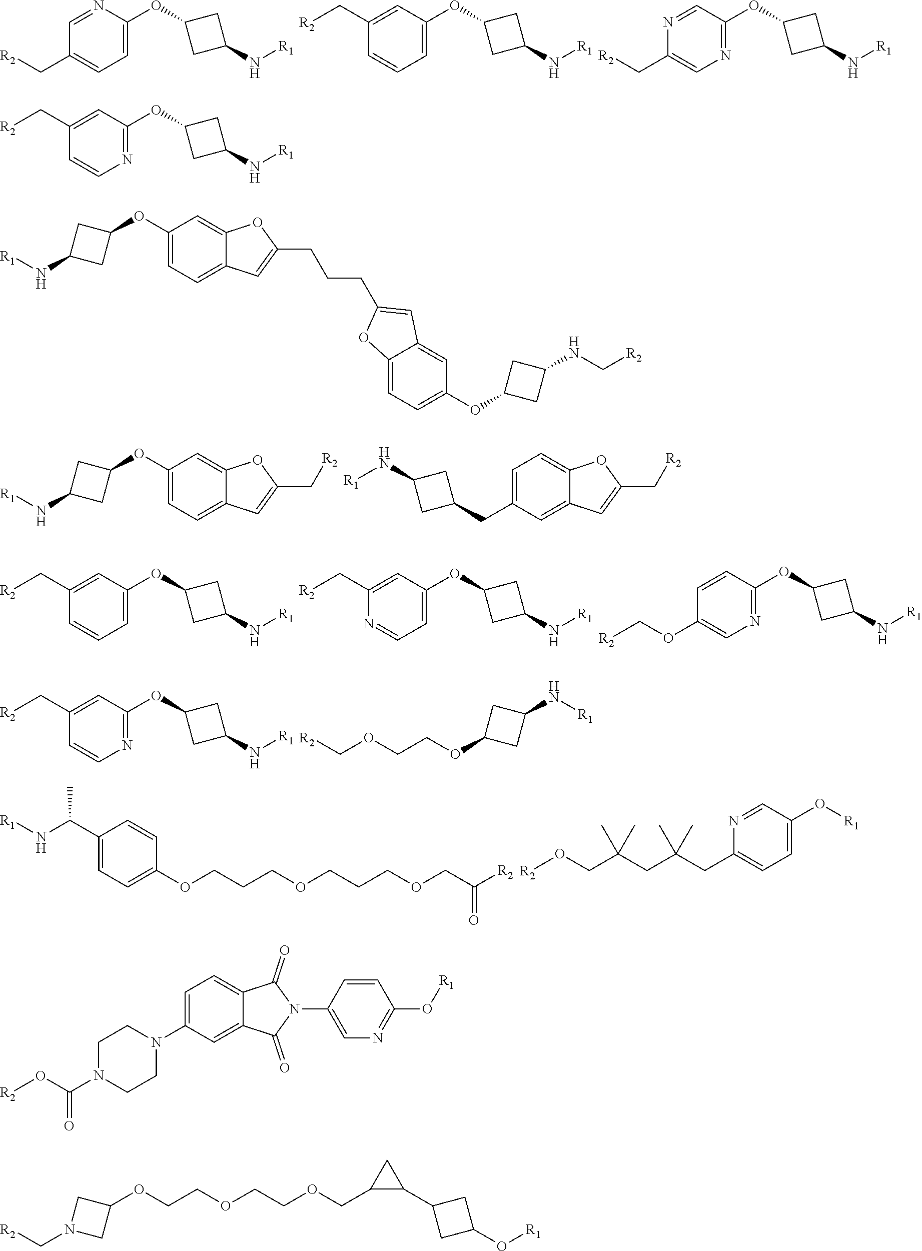

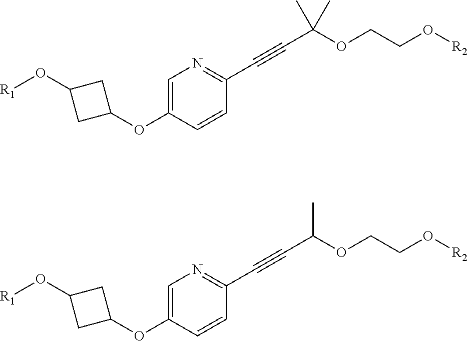

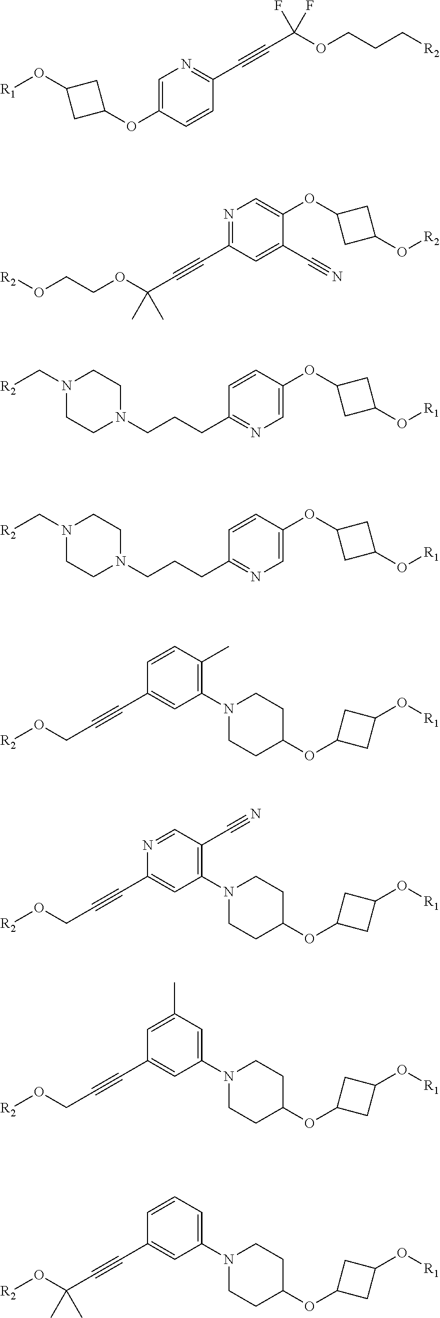

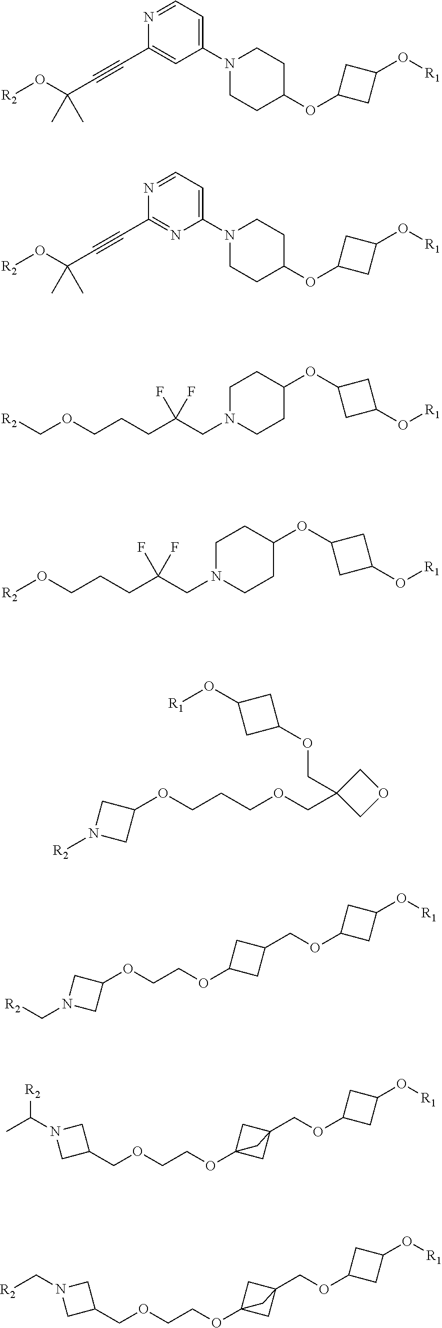

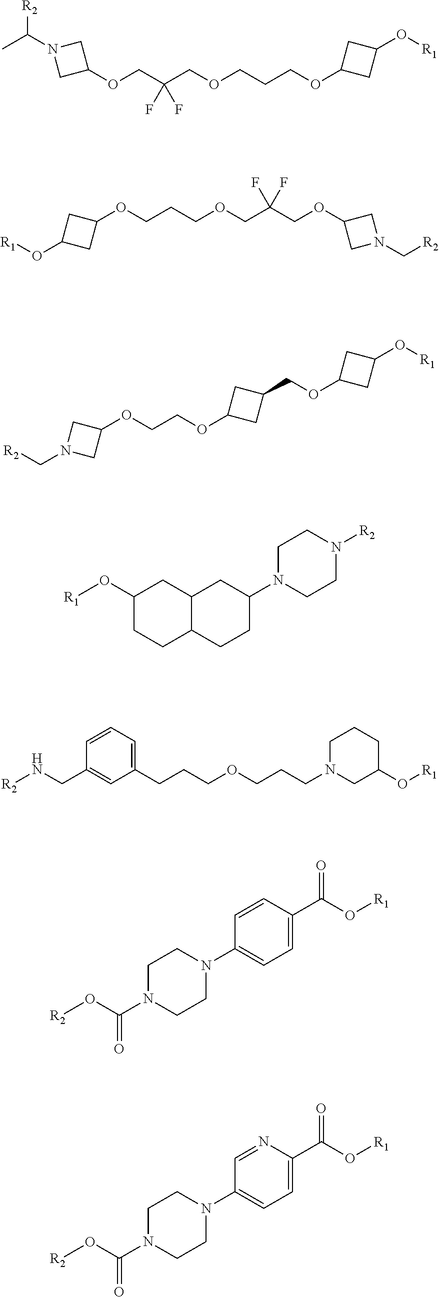

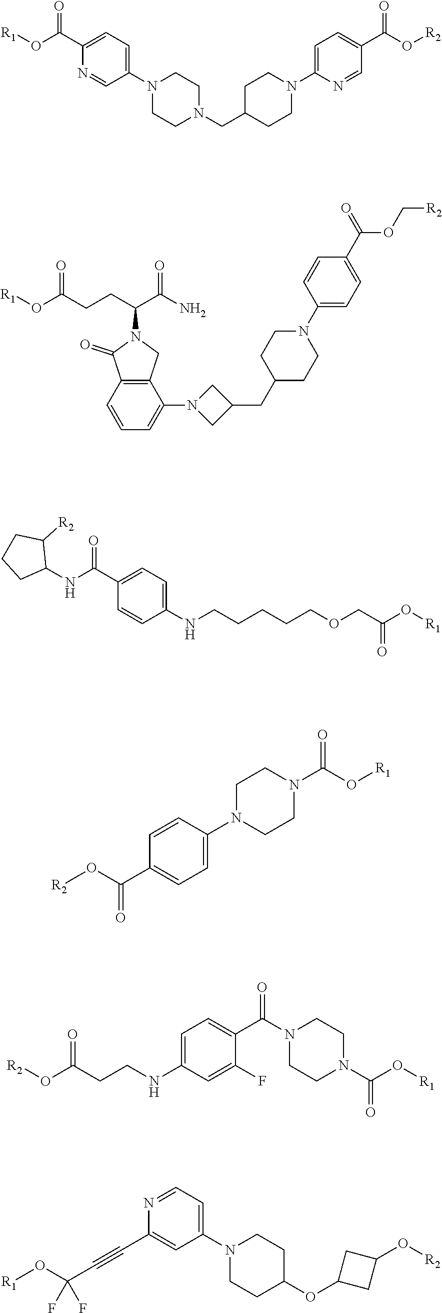

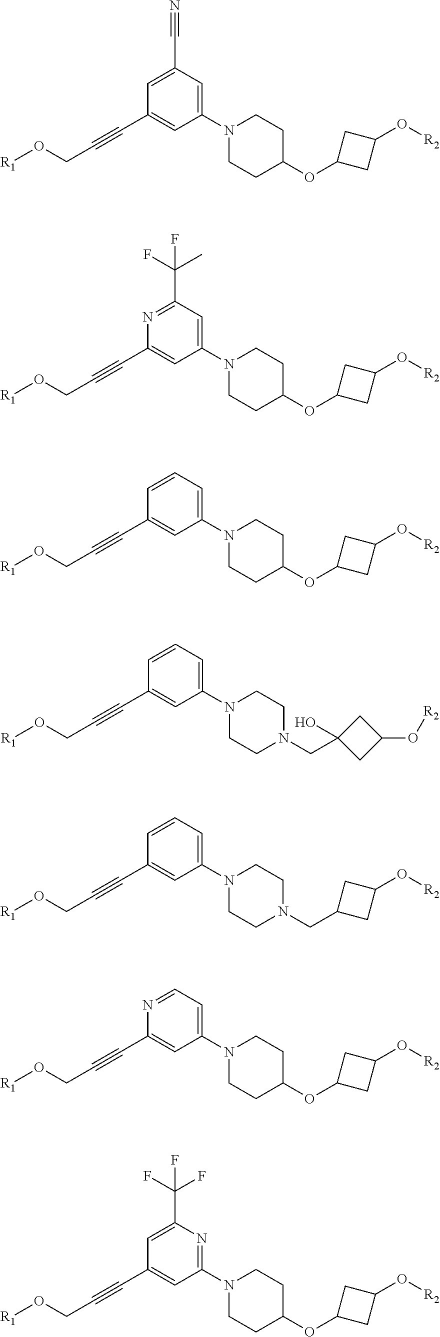

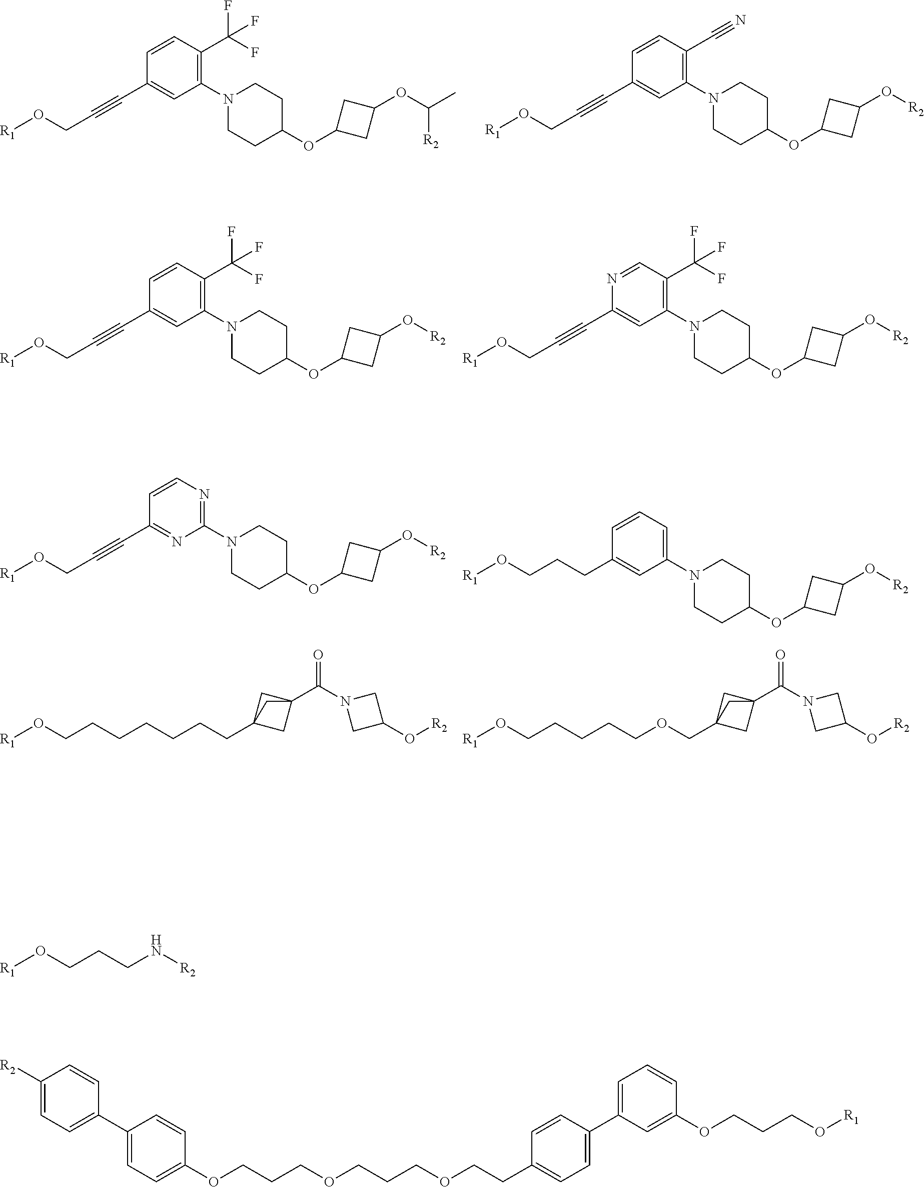

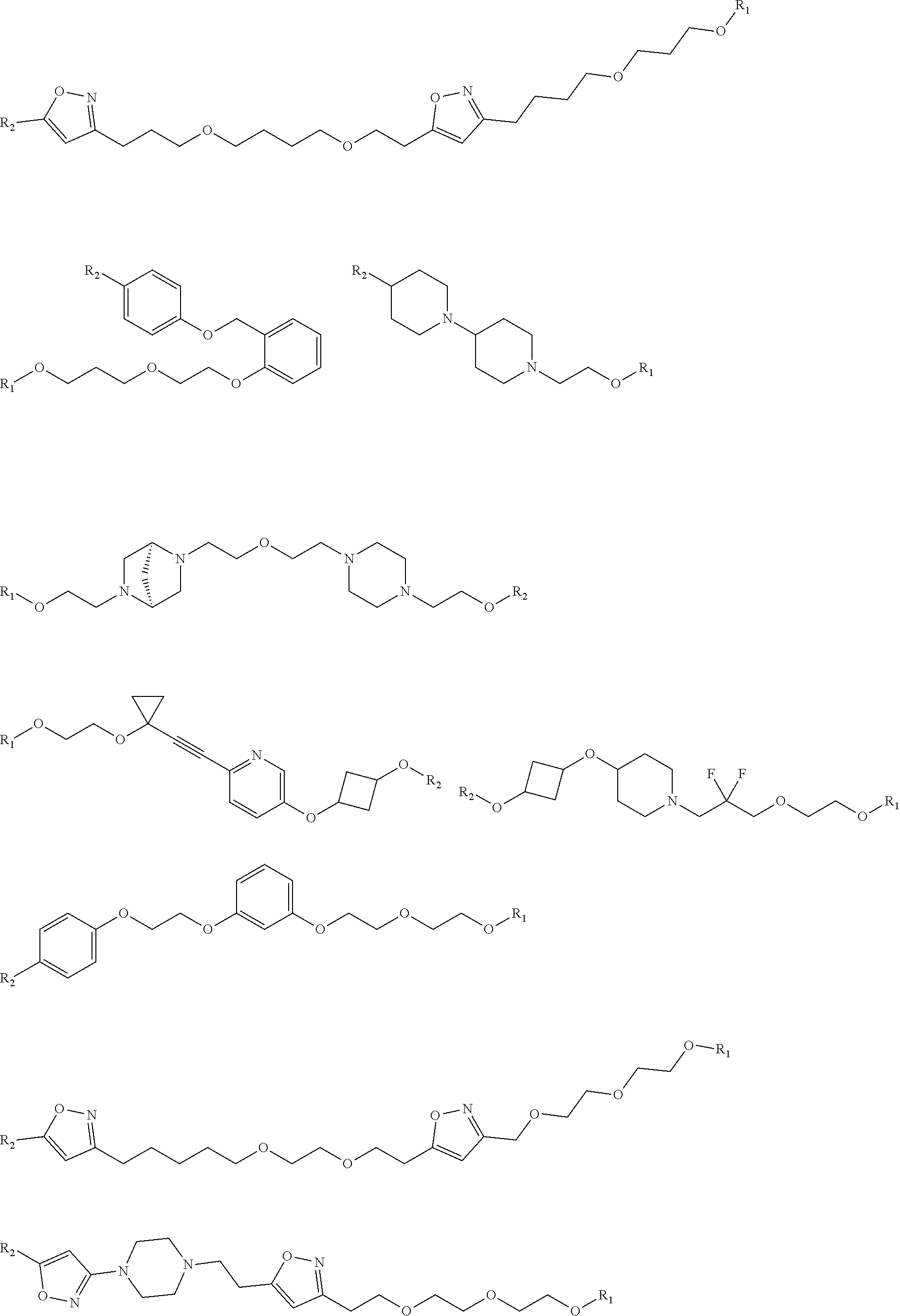

### 3. Insect Proteins of Interest and Protein Targeting Moieties (PTMs)

Generally, any protein in an insect may be targeted by the compounds, compositions, and methods provided herein. Where the goal is to control insect pests, the target protein is a protein that is essential to the growth, development, reproduction, and/or survival of the target insect pest. Target proteins include proteins required for the insect and/or arachnid to maintain its normal physiological and biochemical functions. Inhibition or degradation of the target protein limits the insect's and/or arachnid's ability to feed, grow, or survive. Examples of insect and/or arachnid proteins that may targeted by the provided compounds, compositions, and methods include essential proteins, proteins involved in processes such as development, metabolism, or neurotransmission, and proteins that are targets of existing insecticides and/or arachnids. In a preferred embodiment, the target protein functions in pathways required for one or more cellular functions such as transcription, translation, formation of the cytoskeleton, cell-cycle, metabolism (anabolism or catabolism), endocytosis, intracellular and intercellular transport, calcium binding, nucleus import and export, nucleic acid binding, signal peptidase-protein binding, the proteasome, vesicle transport, neuro-transmission, water-balance, ion-balance, splicing, mitosis, meiosis, chromosome organization, stability or integrity, micro RNAs, siRNAs, posttranslational protein modifications, electron transport, apoptosis, membrane integrity, and cell adhesion. Examples of insect and/or arachnid proteins that may be targeted by the provided compounds, compositions, and methods include essential proteins, proteins involved in processes such as development, metabolism, or neurotransmission, and proteins that are targets of existing insecticides.

The following targets and pathways may be targeted with the insect control PROTACs disclosed herein; examples of exemplary target binders associated with each target are given in parenthesis: (1) Acetylcholinesterase targeted by Carbamates (e.g., Carbofuran, Carbosulfan, Methomyl) or Organophosphates (e.g., Acephate, Chlorpyrifos, Phorate); (2) GABA-gated chloride channel targeted by Cyclodiene Organochlorines (e.g., Chlordane, Endosulfan) or Phenylpyrazoles (e.g., Ethiprole, Fipronil); (3) Sodium channel targeted by Pyrethroids and Pyrethrins (e.g., Bifenthrin, alpha-cypermethrin, Deltamethrin, Esfenvalerate, Etofenprox, lambda-Cyhalothrin, Permethrin, Tefluthrin), Dichiorodiphenyltrichlioroethane (DDT) or Methoxychlor; (4) Nicotinic acetylcholine receptor (nAChR) targeted by Neonicotinoids (e.g., Acetamiprid, Clothianidin, Dinotefuran, Imidacloprid, Nitenpyram, Thiacloprid, Thiamethoxam), Nicotine, Butenolides, Sulfoximines, Mesoionics, and Pyridylidenes; (5) Nicotinic acetylcholine receptor (nAChR) allosterically targeted by Spinosyns (e.g., Spinetoram, Spinosad); (6) Glutamate-gated chloride channel (GluCl) allosterically targeted by Avermectins and Milbemycins (e.g., Abamectin, Emamectin, Lepimectin, Milbemectin); (7) Chordotonal organ TRPV channel targeted by Pyridine azomethine derivatives (e.g., Pymetrozine, Pyrifluquinazon) and Pyropenes (e.g., Afidopyropen); (8) CHS1 affecting mite growth targeted by Clofentezine, Diflovidazin, Hexythiazox, and Etoxazole; (9) Mitochondrial ATP synthase targeted by Diafenthiuron, Organotin miticides (e.g., Azocyclotin, Cyhexatin, Fenbutatin oxide), Propargite, and Tetradifon; (10) Uncouplers of oxidative phosphorylation via disruption of proton gradient targeted by Chlorfenapyr, DNOC, and Sulfluramid; (11) Nicotinic acetylcholine receptor (nAChR) channel targeted by Nereistoxin analogues (e.g., Bensultap, Cartap hydrochloride, Thiocyclam, Thiosultapsodium); (12) Chitin biosynthesis affecting CHS1 targeted by Benzoylureas (e.g., Diflubenzuron, Flufenoxuron, Lufenuron, Novaluron, Teflubenzuron); (13) Chitin biosynthesis type 1 targeted by Buprofezin; (14) Moulting disruptors such as Cyromazine; (15) Ecdysone receptor targeted by Diacylhydrazines (e.g., Chromafenozide, Halofenozide, Methoxyfenozide, Tebufenozide); (16) Octopamine receptor targeted by Amitraz; (17) Mitochondrial complex III electron transport targeted by Hydramethylnon, Fluacrypyrim, Acequinocyl, Bifenazate; (18) Mitochondrial complex I electron transport targeted by METI acaricides and insecticides (e.g., Fenazaquin, Fenpyroximate, Pyridaben, Pyrimidifen, Tebufenpyrad, Tolfenpyrad) and Rotenone; (19) Voltage-dependent sodium channel targeted by Oxadiazines (e.g., Indoxacarb) and Semicarbazones (e.g., Metaflumizone); (20) Acetyl CoA carboxylase targeted by Tetronic & Tetramic acid derivatives (e.g., Spirodiclofen, Spiromesifen, Spiropidion, Spirotetramat); (21) Mitochondrial complex II electron transport targeted by Carboxanilides (e.g., Cyenopyrafen, Cyflumetofen, Pyflubumide); (22) Ryanodine receptor targeted by Chlorantraniliprole, Cyantraniliprole, Flubendiamide, Tetraniliprole, Cyclaniliprole; (23) GABA-gated chloride channel allosterically targeted by Meta-diamides and Isoxazolines (e.g., Broflanilide, Fluxametamide, Isocycloseram); (24) Calcium-activated potassium channel (KCa2) targeted by Acynonapyr; (25) Mitochondrial complex III electron transport targeted by Flometoquin.

Other target proteins of interest include juvenile hormone receptor, Bromodomain Containing 3 (BRD3), Cholone O-Acetyltransferase (ChAT), Dihydrofolate Reductase (DHFR), FK506 binding proteins (FKBP), Geranylgeranyl diphosphate synthase 1 (GGPS1), 3-Hydroxy-3Methylglutaryl-CoA Reductase (HMGCR), Inosine-5′-monophosphate dehydrogenase (IMPDH), Juvenile hormone acid O-methyltranserase (JHAMT), lysine-tRNA ligase (KRS1), MET Proto-Oncogene, Receptor Tyrosine Kinase (MET), Thioredoxin reductases (TXNRD), N-myristoyl transferase (NMT), SWI/SNF Related, Matrix Associated, Actin Dependent Regulator of Chromatin, Subfamily A, Member 2 (SMARCA2), UDP-sugar pyrophosphorylase (USP) and Will Die Slowly (WDS).

Target binders include those selected from, but not limited to, analogues and derivatives of compounds such as Abamectin, Acephate, Acequinocyl, Acetamiprid, Acrinathrin, Acynonapyr, Afidopyropen, Alanycarb, Aldicarb, Allethrin, Amitraz, Azinphos-methyl, Azocyclotin, Benfuracarb, Benomyl, Bensultap, Benzpyrimoxan, Bifenazate, Bifenthrin, Bioallethrin S-cyclopentenyl, Bioresmethrin, Bistrifluron, BPMC, Broflanilide, Bromopropylate, Buprofezin, Cadusafos, Carbaryl, Carbofuran, Carbosulfan, Cartap, Chlorantraniliprole, Chlorethoxyfos, Chlorfenapyr, Chlorfenvinphos, Chlorfluazuron, Chloropicrin, Chlorpyrifos, Chromafenozide, Clofentezine, Clothianidin, Cyrolite, Cyantraniliprole, Cyclaniliprole, Cyclobutrifluram, Cycloprothrin, Cyenopyrafen, Cyetpyrafen, Cyflumetofen, Cyfluthrin, beta-Cyfluthrin, Cyhalothrin, lambda-Cyhalothrin, gamma-Cyhalothrin, Cyhexatin, Cypermethrin, alpha-Cypermethrin, beta-Cypermethrin, theta-Cypermethrin, zeta-Cypermethrin, Cyphenothrin, Cyproflanilide, Cyromazine, Dazomet, DDT, Deltamethrin, Demeton-S-methyl, Diafenthiuron, Diazinon, Dicloromezotiaz, Dichlorvos, Dicofol, Dicrotophos, Diflovidazin, Diflubenzuron, Dimefluthrin, Dimethoate, Dimpropyridaz, Dinotefuran, Disulfoton, DNOC, Emamectin benzoate, Empenthrin, Endosulfan, Esfenvalerate, Ethion, Ethiprole, Ethoprophos, Etofenprox, Etoxazole, Fenamiphos, Fenazaquin, Fenbutatin oxide, Fenitrothion, Fenoxycarb, Fenpropathrin, Fenpyroximate, Fenthion, Fenvalerate, Fipronil, Firmus, Flometoquin, Flonicamid, Fluacrypyrim, Fluazaindolizine, Flubendiamide, Flubrocythrinate, Flucycloxuron, Flucythrinate, Fluensulfone, Flufenoxuron, Flumethrin, Flupentiofenox, Flupyradifurone, Flupyrimin, tau-Fluvalinate, Fluxametamide, Formetanate, Fosthiazate, Halfenprox, Halofenozide, Hexaflumuron, Hexythiazox, Hydramethylnon, Hydropene, Imicyafos, Imidacloprid, Imiprothrin, Indoxacarb, Isocycloseram, Isofenphos, Isoprocarb, Isoxathion, Kadethrin, Kinoprene, Lepimectin, Lindane, Lufenuron, Malathion, Metaflumizone, Metaldehyde, Metam, Methamidophos, Methidathion, Methiocarb, Methomyl, Methoprene, Methoxychlor, Methoxyfenozide, Metofluthrin, Mevinphos, Milbemectin, Momfluorothrin, Monocrotophos, Nicofluprole, Nicotine, Nitenpyram, Novaluron, Noviflumuron, Omethoate, Oxamyl, Oxazosulfyl, Oxydemeton-methyl, Parathion, Parathion-methyl, Permethrin, Phenothrin, Phenthoate, Phorate, Phosalone, Phosmet, Phosphamidon, Phoxim, Pirimicarb, Pirimiphos-methyl, Prallethrin, Profenophos, Profluthrin, Propargite, Prothiofos, Pyflubumide, Pymetrozine, Pyraclofos, Pyridaben, Pyridalyl, Pyridaphenthion, Pyrifluquinazon, Pyrimidifen, Pyriprole, Pyriproxyfen, Quinalphos, Resmethrin, Rotenone, Silafluofen, Spinetoram, Spinosad, Spirodiclofen, Spiromesifen, Spiropidion, Spirotetramat, Sulfoxaflor, Sulfuramid, Tebufenozide, Tebufenpyrad, Tebupirimfos, Teflubenzuron, Tefluthrin, Terbufos, Tetrachlorantraniliprole, Tetradifon, Tetramethrin, Tetraniliprole, Thiacloprid, Thiamethoxam, Thiocyclam, Thiodicarb, Thiosultap-sodium, Tioxazafen, Tolfenpyrad, Tralomethrin, Transfluthrin, Triazamate, Triazophos, Trichlorfon, Triflumezopyrim, Triflumuron, Xylyl methylcarbamate.

When the target protein of interest is WDS, suitable PTMs for WDS include those ligands disclosed in International Patent Application Publication No. WO2019/246570, the contents of which are incorporated herein by reference in their entirety.

WDS Ligands include, but are not limited to:

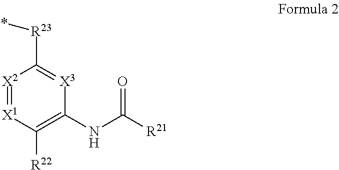

wherein the symbol * indicates a connection to a linker, for example any of the linkers described in Section B.2. R²¹ is C₆-C₁₀ aryl or C₅-C₁₀ heteroaryl. R²¹ is unsubstituted or substituted with one or more of groups selected from halo, ═O, ═S, CN, NO₂, C₁₋₈ alkyl, C₁-C₈ haloalkyl, C₁-C₈ hydroxyalkyl, C₃-C₁₀ cycloalkyl, C₃-C₁₀ heterocyclyl, C₁-C₈ alkyleneOR²⁴, C₁-C₈ alkyleneSR²⁵, C₁-C₈alkylene NR²⁶R²⁷, C₂-C₈ alkenyl, C₂-C₈ alkynyl, OR²⁴, SR²⁵, NR²⁶R²⁷. R²² is heterocycloalkyl, which contains one or more nitrogen atoms. R²² is unsubstituted or substituted with one or more of groups selected from halo, ═O, ═S, CN, NO₂, C₁-C₈ alkyl, C₁-C₈ haloalkyl, C₁-C₈ hydroxyalkyl, C₃-C₁₀ cycloalkyl, C₃-C₁₀ heterocyclyl, C₂-C₈ alkenyl, C₂-C₈ alkynyl, OR²⁸, SR²⁹, NR³⁰R³¹, C₁-C₈ alkyleneOR²⁸, C₁-C₈ alkyleneSR²⁹, C₁-C₈ alkyleneNR³⁰R³¹. R²³ is selected from C₆-C₁₀ aryl, C₅-C₁₀ heteroaryl, or heterocycloalkyl, heterocycloalkenyl. R²³ is unsubstituted or substituted with one or more of groups selected from halo, CN, NO₂, ═O, ═S, OR³², SR³³, SO₂R³⁴, NR³⁵R³⁶, R³⁷, C₁-C₈ alkyl, C₁-C₈ haloalkyl, C₁-C₈ hydroxyalkyl, C₃-C₁₀ cycloalkyl, C₃-C₁₀ heterocyclyl, C₂-C₈ alkenyl, C₂-C₈ alkynyl, C₁-C₈ alkyleneR³⁷, C₂-C₈ alkenyleneR³⁷, C₂-C₈ alkynyleneR³⁷, OC₁-C₈ alkyleneR³⁷, SC₁-C₈ alkyleneR³⁷, C₁-C₈ alkyleneOR³², C₁-C₈ alkyleneSR³³, C₁-C₈ alkyleneNR³⁵R³⁶, OC₁-C₈ alkyleneOR³², OC₁-C₈ alkyleneSR³³, OC₁-C₈ alkyleneNR³⁵R³⁶, SC₁-C₈ alkyleneOR³², SC₁-C₈ alkyleneSR³³, SC₁-C₈ alkyleneNR³⁵R³⁶, C(O)R³², C(O)OR³², C(S)OR³², C(O)NR³⁵R³⁶, C(S) NR³⁵R³⁶, NR³⁵C(O)R³², NR³⁵S(O)R³², NR³⁵S(O)OR³², S(O)R³³, S(O)OR³², and S(O)ONR³⁵R³⁶. R²⁴, R²⁵, R²⁶, R²⁷, R²⁸, R²⁹, R³⁰, and R³¹ are independently selected from H, C₁-C₈ alkyl, C₁-C₈ haloalkyl, C₁-C₈ hydroxyalkyl, C₃-C₁₀ cycloalkyl, C₃-C₁₀ heterocyclyl, C(O)C₁-C₈ alkyl, C(O)C₁-C₈ haloalkyl, C(O)C₁-C₈ hydroxyalkyl, C(O)C₃-C₁₀ cycloalkyl, and C(O)C₃-C₁₀ heterocyclyl, or R²⁶ and R²⁷; R³⁰ and R³¹ together with the nitrogen atom to which they are connected can independently form 3-10 membered heterocyclyl rings. R³², R³³, and R³⁴ are independently selected from H, C₁-C₈ alkyl, C₁-C₈ haloalkyl, C₁-C₈ alkoxyalkyl, C₁-C₈ hydroxyalkyl, C₃-C₈ cycloalkyl, C₃-C₇ heterocycloalkyl, C₆-C₁₀ aryl, C₅-C₁₀ heteroaryl, C(O)C₁-C₈ alkyl, C(O)C₁-C₈ haloalkyl, C(O)C₁-C₈ hydroxyalkyl, C(O)C₁-C₈ alkoxyalkyl, C(O)C₃-C₁₀ cycloalkyl, C(O)C₃-C₁₀ heterocyclyl, C(O)C₆-C₁₀ aryl, C(O)C₅-C₁₀ heteroaryl, C₁-C₈ alkyleneC₃-C₁₀ cycloalkyl, C₁-C₈ alkyleneC₃-C₁₀ heterocycloalkyl, C₁-C₈ alkyleneC₆-C₁₀ aryl, C₁-C₈ alkyleneC₅-C₁₀ heteroaryl. R³⁵ and R³⁶ are independently selected from H, C₁-C₈ alkyl, C₁-C₈ haloalkyl, C₁-C₈ alkoxyalkyl, C₁-C₈ hydroxyalkyl, C₃-C₁₀ cycloalkyl, C₃-C₁₀ heterocycloalkyl, C₆-C₁₀ aryl, C₅-C₁₀ heteroaryl, C(O)C₁-C₈ alkyl, C(O)C₁-C₈ haloalkyl, C(O)C₁-C₈ hydroxyalkyl, C(O)C₁-C₈ alkoxyalkyl, C(O)C₃-C₁₀ cycloalkyl, C(O)C₃-C₁₀ heterocycloalkyl, C(O)C₆-C₁₀ aryl, C(O)C₅-C₁₀ heteroaryl, C(O)OC₁-C₈ alkyl, C(O)OC₁-C₈ haloalkyl, C(O)OC₁-C₈ hydroxyalkyl, C(O)OC₁-C₈ alkoxyalkyl, C(O)OC₃-C₁₀ cycloalkyl, C(O)OC₃-C₁₀ heterocyclyl, C(O)OC₆-C₁₀ aryl, C(O)OC₅-C₁₀ heteroaryl, C(O)NC₁-C₈ alkyl, C(O)NC₁-C₈ haloalkyl, C(O)NC₁-C₈ hydroxyalkyl, C(O)NC₁-C₈ alkoxyalkyl, C(O)NC₃-C₁₀ cycloalkyl, C(O)NC₃-C₁₀ heterocyclyl, C(O)NC₆-C₁₀ aryl, C(O)NC₅-C₁₀ heteroaryl, SO₂C₁-C₈ alkyl, SO₂C₁-C₈ haloalkyl, SO₂C₁-C₈ hydroxyalkyl, SO₂C₁-C₈ alkoxyalkyl, SO₂C₃-C₁₀ cycloalkyl, SO₂C₃-C₁₀ heterocyclyl, SO₂C₆-C₁₀ aryl, SO₂C₅-C₁₀ heteroaryl, C₁-C₈ alkyleneC₃-C₁₀ cycloalkyl, C₁-C₈ alkyleneC₃-C₁₀ heterocycloalkyl, C₁-C₈ alkyleneC₆-C₁₀ aryl, C₁-C₈ alkyleneC₅-C₁₀ heteroaryl, or R³⁵ and R³⁶ together with the nitrogen atom to which they are connected can independently form 3-10 membered heterocyclyl rings. R³⁷ is selected from C₃-C₁₀ cycloalkyl, C₃-C₁₀ heterocycloalkyl, C₆-C₁₀ aryl, C₅-C₁₀ heteroaryl, C(O)C₁-C₈ alkyl, C(O)C₁-C₈ haloalkyl, C(O)C₁-C₈ hydroxyalkyl, C(O)C₁-C₈ alkoxyalkyl, C(O)C₃-C₁₀ cycloalkyl, C(O)C₃-C₁₀ heterocycloalkyl, C(O)C₆-C₁₀ aryl, and C(O)C₅-C₁₀ heteroaryl. X₁, X₂, and X₃ are independently selected from CR³⁸, and N. R³⁸ is selected from H, F, Cl, C₁₋₈ alkyl, C₁-C₈ haloalkyl, C₁-C₈ alkoxyalkyl, or C₃-C₈ cycloalkyl.

In some aspects of Formula 2, R²¹ has a structure of:

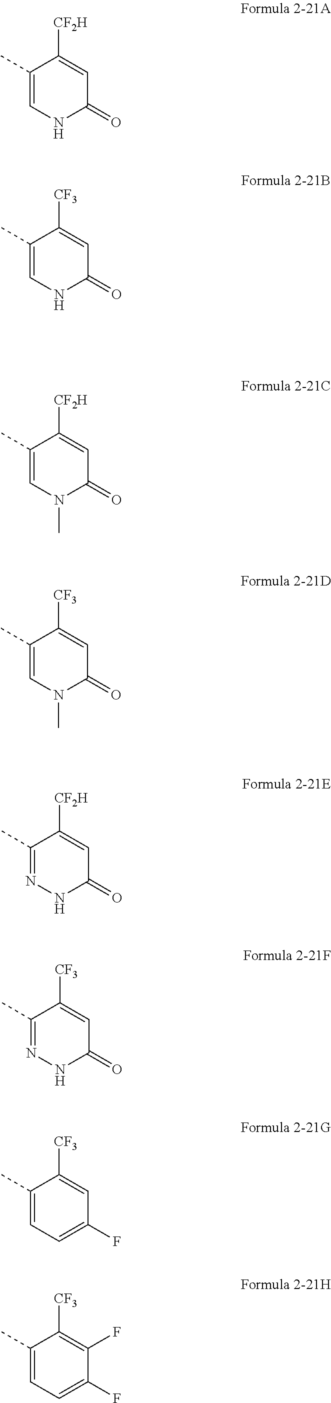

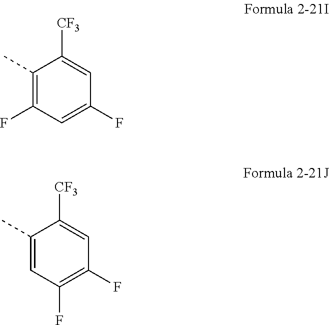

In some aspects of Formula 2, R²² has a structure of:

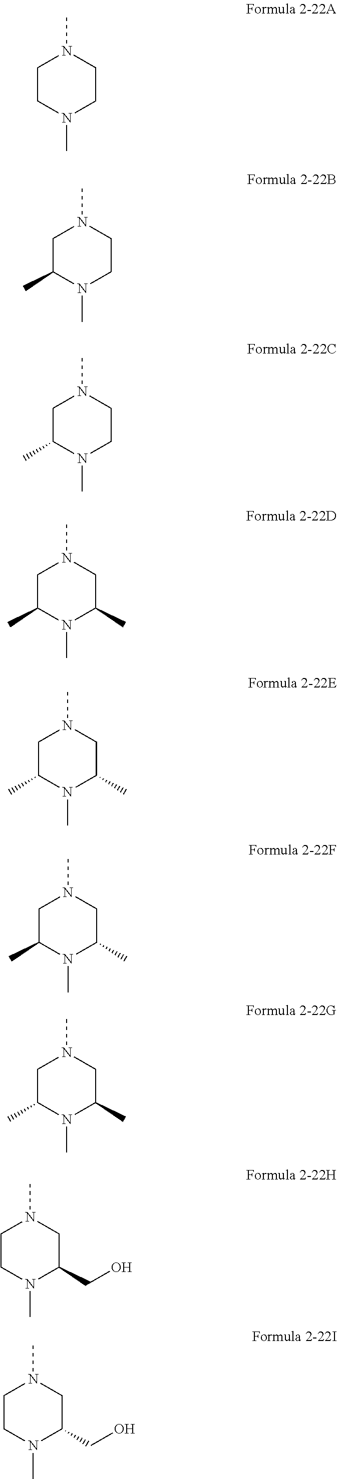

In some aspects of Formula 2, R²³ has a structure of:

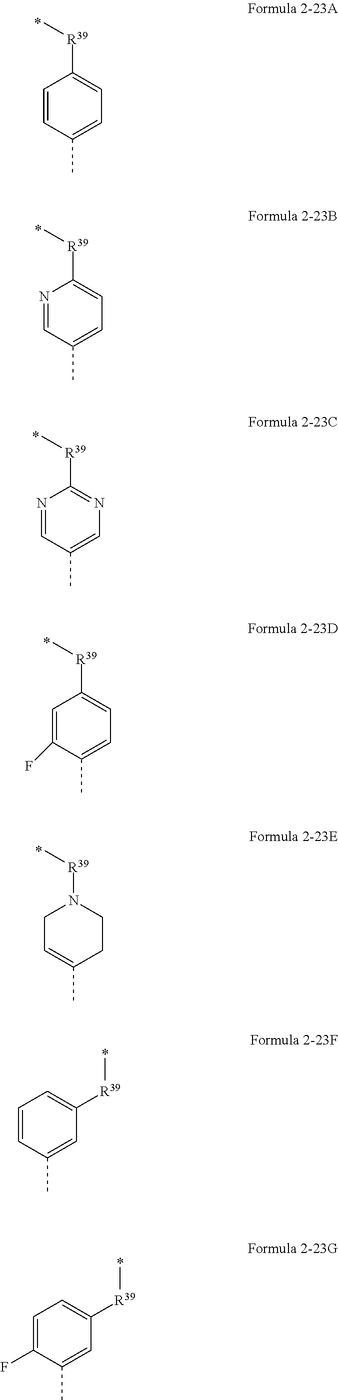

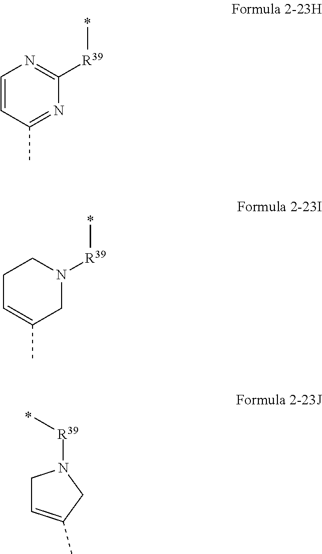

wherein the symbol * indicates a connection to a linker, for example any of the linkers described in Section B.2. R³⁹ is selected from a bond, C₁-C₈ alkyl, C₁-C₈ haloalkyl, OR⁴⁰, SR⁴⁰, SO₂R⁴⁰, NR⁴¹R⁴², R⁴³, C₁-C₈ alkyleneR⁴³, C₂-C₈ alkenyleneR⁴³, OC₁-C₈ alkyleneR⁴³, SC₁-C₈ alkyleneR⁴³, C₁-C₈ alkyleneOR⁴⁰, C₁-C₈ alkyleneSR⁴⁰, C₁-C₈ alkyleneNR⁴¹R⁴², OC₁-C₈ alkyleneOR⁴⁰, OC₁-C₈ alkyleneSR⁴⁰, OC₁-C₈ alkyleneNR⁴¹R⁴², SC₁-C₈ alkyleneOR⁴⁰, SC₁-C₈ alkyleneSR⁴⁰, SC₁-C₈ alkyleneNR⁴¹R⁴², C(O)OR⁴⁰, C(S)OR⁴⁰, C(O) NR⁴¹R⁴², C(S) NR⁴¹R⁴². R⁴⁰ is selected from H, C₁-C₈ alkyl, C₁-C₈ haloalkyl, C₁-C₈alkoxyalkyl, C₁-C₈ hydroxyalkyl, C₃-C₈ cycloalkyl, C₃-C₇ heterocycloalkyl, C₆-C₁₀ aryl, C₅-C₁₀ heteroaryl, C(O)C₁-C₈ alkyl, C(O)C₁-C₈ haloalkyl, C(O)C₁-C₈ hydroxyalkyl, C(O)C₁-C₈ alkoxyalkyl, C(O)C₃-C₁₀ cycloalkyl, C(O)C₃-C₁₀ heterocyclyl, C(O)C₆-C₁₀ aryl, C(O)C₅-C₁₀ heteroaryl, C₁-C₈ alkyleneC₃-C₁₀ cycloalkyl, C₁-C₈ alkyleneC₃-C₁₀ heterocycloalkyl, C₁-C₈alkyleneC₆-C₁₀ aryl, C₁-C₈alkyleneC₅-C₁₀ heteroaryl, R⁴¹ and R⁴² are independently selected from H, C₁-C₈ alkyl, C₁-C₈ haloalkyl, C₁-C₈ alkoxyalkyl, C₁-C₈ hydroxyalkyl, C₃-C₁₀ cycloalkyl, C₃-C₁₀ heterocycloalkyl, C₆-C₁₀ aryl, C₅-C₁₀ heteroaryl, C(O)C₁-C₈ alkyl, C(O)C₁-C₈ haloalkyl, C(O)C₁-C₈ hydroxyalkyl, C(O)C₁-C₈ alkoxyalkyl, C(O)C₃-C₁₀ cycloalkyl, C(O)C₃-C₁₀ heterocycloalkyl, C(O)C₆-C₁₀ aryl, C(O)C₅-C₁₀ heteroaryl, C(O)OC₁-C₈ alkyl, C(O)OC₁-C₈ haloalkyl, C(O)OC₁-C₈ hydroxyalkyl, C(O)OC₁-C₈ alkoxyalkyl, C(O)OC₃-C₁₀ cycloalkyl, C(O)OC₃-C₁₀ heterocyclyl, C(O)OC₆-C₁₀ aryl, C(O)OC₅-C₁₀ heteroaryl, C(O)NC₁-C₈ alkyl, C(O)NC₁-C₈ haloalkyl, C(O)NC₁-C₈ hydroxyalkyl, C(O)NC₁-C₈ alkoxyalkyl, C(O)NC₃-C₁₀ cycloalkyl, C(O)NC₃-C₁₀ heterocyclyl, C(O)NC₆-C₁₀ aryl, C(O)NC₅-C₁₀ heteroaryl, SO₂C₁-C₈ alkyl, SO₂C₁-C₈ haloalkyl, SO₂C₁-C₈ hydroxyalkyl, SO₂C₁-C₈ alkoxyalkyl, SO₂C₃-C₁₀ cycloalkyl, SO₂C₃-C₁₀ heterocyclyl, SO₂C₆-C₁₀ aryl, SO₂C₅-C₁₀ heteroaryl, C₁-C₈ alkyleneC₃-C₁₀ cycloalkyl, C₁-C₈ alkyleneC₃-C₁₀ heterocycloalkyl, C₁-C₈ alkyleneC₆-C₁₀ aryl, C₁-C₈ alkyleneC₅-C₁₀ heteroaryl, or R⁴¹ and R⁴² together with the nitrogen atom to which they are connected can independently form 3-10 membered heterocyclyl rings. R⁴³ is selected from C₃-C₁₀ cycloalkyl, C₃-C₁₀ heterocycloalkyl, C₆-C₁₀ aryl, C₅-C₁₀ heteroaryl, C(O)C₁-C₈ alkyl, C(O)C₁-C₈ haloalkyl, C(O)C₁-C₈ hydroxyalkyl, C(O)C₁-C₈ alkoxyalkyl, C(O)C₃-C₁₀ cycloalkyl, C(O)C₃-C₁₀ heterocycloalkyl, C(O)C₆-C₁₀ aryl, and C(O)C₅-C₁₀ heteroaryl.

Additional WDS Ligands include, but are not limited to:

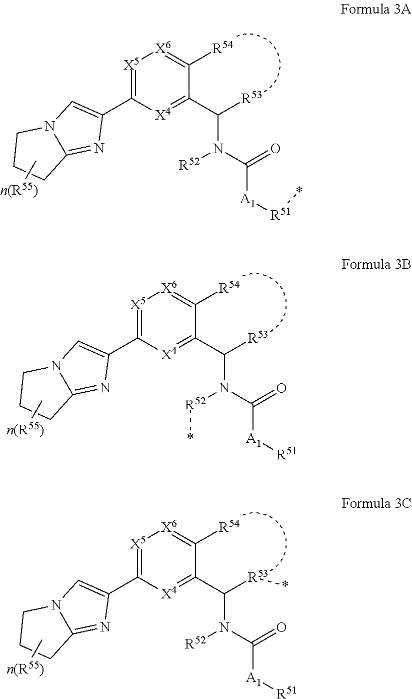

wherein the symbol * indicates a connection to a linker, for example any of the linkers described in Section B.2. X⁴, X⁵, and X⁶ are independently selected from null, CR⁵⁶, and N, wherein R⁵⁶, at each occurrence, is independently selected from hydrogen, halogen, cyano, nitro, optionally substituted C₁-C₈ alkyl, optionally substituted C₁-C₈ haloalkyl, optionally substituted C₁-C₈ alkoxy, optionally substituted C₁-C₈ haloalkoxy, optionally substituted C₁-C₈alkylamino, optionally substituted C₁-C₈ haloalkylamino, optionally substituted C₁-C₈ alkoxycarbonyl, optionally substituted C₁-C₈ haloalkoxycarbonyl, optionally substituted C₁-C₈ alkylaminocarbonyl, optionally substituted C₁-C₈ haloalkylaminocarbonyl, optionally substituted C₃-C₈ carbocyclyl, and optionally substituted C₄-C₈ heterocyclyl; A1 is selected from null, optionally substituted C₁-C₈ alkylene, optionally substituted C₁-C₈ haloalkylene, optionally substituted C₁-C₈ alkylamino, optionally substituted C₁-C₈ alkyleneamino, optionally substituted C₁-C₈ haloalkylamino, optionally substituted C₂-C₈ alkenylene, optionally substituted C₂-C₈ haloalkenylene, optionally substituted C₂-C₈ alkenyleneamino, optionally substituted C₂-C₈ haloalkenyleneamino, optionally substituted C₂-C₈ alkynylene, optionally substituted C₂-C₈ haloalkynylene, optionally substituted C₂-C₈ alkynyleneamino, optionally substituted C₂-C₈ haloalkynyleneamino, optionally substituted C₃-C₈ carbocyclyl, and optionally substituted C₄-C₈ heterocyclyl; R⁵¹ is selected from selected from null, carbocyclyl, heterocyclyl, aryl, and heteroaryl, which are optionally substituted with one or more substituents independently selected from hydrogen, halogen, oxo, CN, NO₂, OR⁵⁷, SR⁵⁷, NR⁵⁷R⁵⁸, OCOR⁵⁷, OCO₂R⁵⁷, OCON(R⁵⁷)R⁵⁸, COR⁵⁷, CO₂R⁵⁷, CON(R⁵⁷)R⁵⁷, SOR⁵⁷, SO₂R⁵⁷, SO₂N(R⁵⁷)R⁵⁸, NR⁵⁹CO₂R⁵⁷, NR⁵⁹COR⁵⁷, NR⁵⁹C(O)N(R⁵⁷)R⁵⁸, NR⁵⁹SOR⁵⁷, NR⁵⁹SO₂R⁵⁷, NR⁵⁹SO₂N(R⁵⁷)R⁵⁸, optionally substituted C₁-C₈ alkyl, optionally substituted C₂-C₈ alkenyl, optionally substituted C₂-C₈ alkynyl, optionally substituted C₁-C₈ alkoxyC₁-C₈alkyl, optionally substituted C₁-C₈alkylaminoC₁-C₈alkyl, optionally substituted 4-10 membered heterocyclylC₁-C₈alkyl, optionally substituted 3-10 membered carbocyclylC₁-C₈alkyl, optionally substituted 3-10 membered carbocyclyl, optionally substituted 4-10 membered heterocyclyl, optionally substituted aryl, and optionally substituted heteroaryl, wherein R⁵⁷, R⁵⁸, and R⁵⁹ are independently selected from hydrogen, optionally substituted C₁-C₈ alkyl, optionally substituted C₂-C₈ alkenyl, optionally substituted C₂-C₈ alkynyl, optionally substituted C₁-C₈ alkoxy, optionally substituted C₁-C₈alkoxyC₁-C₈alkyl, optionally substituted C₁-C₈ alkylaminoC₁-C₈alkyl, optionally substituted 3-10 membered carbocyclylC₁-C₈alkyl, optionally substituted 4-10 membered heterocyclylC₁-C₈alkyl, optionally substituted 3-10 membered carbocyclyl, optionally substituted 4-10 membered heterocyclyl, optionally substituted aryl, and optionally substituted heteroaryl, or R⁵⁷ and R⁵⁸, R⁵⁷ and R⁵⁹ together with the atom to which they are connected form a 4-20 membered heterocyclyl ring; R⁵² is selected from null, hydrogen, optionally substituted C₁-C₈ alkyl, optionally substituted C₁-C₈ haloalkyl, optionally substituted C₃-C₈ carbocyclyl, optionally substituted C₄-C₈ heterocyclyl, optionally substituted aryl, and optionally substituted heteroaryl; R⁵³ is selected from null, hydrogen, halogen, cyano, nitro, optionally substituted C₁-C₈ alkyl, optionally substituted C₁-C₈ haloalkyl, optionally substituted C₃-C₈ carbocyclyl, optionally substituted C₄-C₈ heterocyclyl, optionally substituted C₂-C₈ alkenylene, optionally substituted C₂-C₈ alkynylene, optionally substituted aryl, and optionally substituted heteroaryl; R⁵⁴ is selected from null, hydrogen, halogen, cyano, nitro, OR⁶⁰, NR⁶⁰R⁶¹, optionally substituted C₁-C₈ alkyl, optionally substituted C₃-C₈ carbocyclyl, optionally substituted C₄-C₈ heterocyclyl, optionally substituted C₂-C₈ alkenylene, optionally substituted C₂-C₈ alkynylene, optionally substituted aryl, and optionally substituted heteroaryl, wherein R⁶⁰, and R⁶¹, are independently selected from hydrogen, optionally substituted C₁-C₈ alkyl, optionally substituted C₃-C₈ carbocyclyl, optionally substituted C₄-C₈ heterocyclyl, optionally substituted C₂-C₈ alkenylene, optionally substituted C₂-C₈ alkynylene, optionally substituted aryl, and optionally substituted heteroaryl; R⁵³ and R⁵⁴, together with the atoms to which they are connected optionally form a 4-8 membered carbocyclyl ring, or 4-8 membered heterocyclyl ring; R⁵⁵, at each occurrence, is independently selected from hydrogen, halogen, hydroxyl, cyano, nitro, optionally substituted C₁-C₈ alkyl, optionally substituted C₁-C₈ haloalkyl, optionally substituted C₁-C₈ alkoxy, optionally substituted C₁-C₈ alkylamino, optionally substituted C₁-C₈ haloalkylamino, optionally substituted C₃-C₈ carbocyclyl, and optionally substituted C₄-C₈ heterocyclyl; and n=0-6.

In some aspects of Formulae 3A, 3B and 3C, X⁴, X⁵, and X⁶ are CR⁵⁶. In some aspects of Formulae 3A, 3B and 3C, X⁴ and X⁵ are CR⁵⁶; and X⁶ is N.

In some aspects of Formulae 3A, 3B and 3C, R⁵⁶ is selected from hydrogen, halogen, optionally substituted C₁-C₈ alkyl, optionally substituted C₁-C₈ alkoxy, optionally substituted C₁-C₈ alkylamino, optionally substituted C₁-C₈ alkoxycarbonyl, optionally substituted C₃-C₈ carbocyclyl, and optionally substituted C₄-C₈ heterocyclyl. In some aspects of Formulae 3A, 3B and 3C, R⁵⁶ is selected from H, F, Cl, Br, CH₃, CH₃O, and CH₃O(CO)—.

In some aspects of Formulae 3A, 3B and 3C, R⁵⁶ is H. In some aspects of Formulae 3A, 3B and 3C, A1 is selected from null, optionally substituted C₁-C₈ alkylene, optionally substituted C₁-C₈ alkylamino, optionally substituted C₁-C₈ alkyleneamino, optionally substituted C₂-C₈ alkenylene, optionally substituted C₂-C₈ alkenyleneamino, optionally substituted C₂-C₈ alkynylene, and optionally substituted C₂-C₈ alkynyleneamino.

In some aspects of Formulae 3A, 3B and 3C, A1 is selected from null, and optionally substituted C₁-C₈ alkylene. In some aspects of Formulae 3A, 3B and 3C, A1 is null.

In some aspects of Formulae 3A, 3B and 3C, A1 is CH₂. In some aspects of Formulae 3A, 3B and 3C, R⁵¹ is selected from selected from null, carbocyclyl, heterocyclyl, aryl, and heteroaryl, which are optionally substituted with one or more substituents independently selected from hydrogen, halogen, oxo, CN, NO₂, optionally substituted C₁-C₈ alkyl, optionally substituted C₂-C₈ alkenyl, optionally substituted C₂-C₈ alkynyl, optionally substituted C₁-C₈ alkoxyC₁-C₈alkyl, optionally substituted C₁-C₈alkylaminoC₁-C₈alkyl, optionally substituted C₁-C₈ alkoxy, optionally substituted C₁-C₈alkylamino, optionally substituted 4-10 membered heterocyclylC₁-C₈alkyl, optionally substituted 3-10 membered carbocyclylC₁-C₈alkyl, optionally substituted 4-10 membered heterocyclyloxy, optionally substituted 3-10 membered carbocyclyloxy, optionally substituted 3-10 membered carbocyclyl, and optionally substituted 4-10 membered heterocyclyl.

In some aspects of Formulae 3A, 3B and 3C, R⁵¹ is selected from aryl and heteroaryl, which are optionally substituted with one or more substituents independently selected from hydrogen, halogen, oxo, CN, NO₂, optionally substituted C₁-C₈ alkyl, optionally substituted C₂-C₈ alkenyl, optionally substituted C₂-C₈ alkynyl, optionally substituted C₁-C₈ alkoxyC₁-C₈alkyl, optionally substituted C₁-C₈ alkylaminoC₁-C₈alkyl, optionally substituted C₁-C₈ alkoxy, optionally substituted C₁-C₈ alkylamino, optionally substituted 4-10 membered heterocyclylC₁-C₈alkyl, optionally substituted 3-10 membered carbocyclylC₁-C₈alkyl, optionally substituted 4-10 membered heterocyclyloxy, optionally substituted 3-10 membered carbocyclyloxy, optionally substituted 3-10 membered carbocyclyl, and optionally substituted 4-10 membered heterocyclyl.

In some aspects of Formulae 3A, 3B and 3C, R⁵² is selected from null, hydrogen, optionally substituted C₁-C₈ alkyl, optionally substituted C₁-C₈ haloalkyl, optionally substituted C₃-C₈ cycloalkyl, optionally substituted C₄-C₈ heterocycloalkyl, optionally substituted aryl, and optionally substituted heteroaryl.

In some aspects of Formulae 3A, 3B and 3C, R⁵² is selected from null, hydrogen, optionally substituted C₁-C₈ alkyl, optionally substituted C₃-C₈ cycloalkyl, and optionally substituted C₃-C₈ cycloalkylC₁-C₈ alkyl. In some aspects of Formulae 3A, 3B and 3C, R⁵³ is selected from null, hydrogen, and optionally substituted C₁-C₈ alkyl.

In some aspects of Formulae 3A, 3B and 3C, R⁵³ is selected from null, hydrogen, methyl, methylene, ethyl, ethylene, isopropyl, and cyclopropyl. In some aspects of Formulae 3A, 3B and 3C, R⁵⁴ is selected from null, hydrogen, halogen, optionally substituted C₁-C₈ alkyl, optionally substituted C₁-C₈ alkoxy, optionally substituted C₁-C₈ alkylamino, optionally substituted C₃-C₈ cycloalkyl, optionally substituted C₃-C₈ cycloalkoxy, optionally substituted C₃-C₈ cycloalkylamino, optionally substituted C₄-C₈ heterocyclyl, optionally substituted C₂-C₈ alkenylene, optionally substituted C₂-C₈ alkynylene, optionally substituted aryl, optionally substituted aryloxy, optionally substituted arylamino, and optionally substituted heteroaryl. In some aspects of Formulae 3A, 3B and 3C, R⁵³ and R⁵⁴, together with the atoms to which they are connected optionally form a 5-membered carbocyclyl ring, 6-membered carbocyclyl ring, 5-membered heterocyclyl ring, or 6-membered heterocyclyl ring.

In some aspects of Formulae 3A, 3B and 3C, R⁵³ and R⁵⁴, together with the atoms to which they are connected optionally form a 5-membered carbocyclyl ring. In some aspects of Formulae 3A, 3B and 3C, R⁵⁵, at each occurrence, is independently selected from hydrogen, halogen, optionally substituted C₁-C₈ alkyl, optionally substituted C₁-C₈ alkoxy, optionally substituted C₁-C₈ alkylamino, optionally substituted C₃-C₈ carbocyclyl, and optionally substituted C₄-C₈ heterocyclyl.

In some aspects of Formulae 3A, 3B and 3C, R⁵⁵ is hydrogen.

When the target protein of interest is BRD3, suitable PTMs include those known in the art and described in, for example, Doroshow et al, Annals of Oncology, 2017, 28, 1776-1787; Perez-Salviaa and Esteller Epigenetics, 2017, 12, 323-339; Klein, R M D Open, 2018, 4:e000744; Ocana et al, Oncotarget, 2017, 8, 71285-71291; Hogg et al, Blood, 2017, 130, 2537; U.S. Patent Application Publication Nos. 2016/0095867, 2018/0117030, and 2018/0117165, International Patent Application Publications WO 2009/084693, WO 2011/054843, WO 2015/022332, and WO2017/180417; and Japanese Patent Application Publication No. JP2008-156311.

In some embodiments, the BRD3 binders, i.e., PTMs, include those selected from, but not limited to, olinone (CAS No. 1770789-37-1), JQ1 (CAS No. 1268524-70-4), Apabetalone/RVX-208/RVX000222 (CAS No. 1044870-39-4), PF-1 (1403764-72-6), Mivebresib/ABBV-075 (CAS No. 1445993-26-9), BAY1238097 (CAS No. 1564268-08-1), BI 894999 (CAS No. 1660117-38-3), BMS-986158 (CAS No. 1800340-40-2), CPI-0610 (CAS No. 1380087-89-7), FT-1101 (CAS No. 1776060-36-6), Alobresib/GS-5829 (CAS No. 1637771-14-2), I-BET151 (CAS No. 1300031-49-5), INCB054329 (CAS No. 1628607-64-6), Birabresib/OTX015/MK-8628 (CAS No. 202590-98-5), PLX51107 (CAS No. 1627929-55-8), R⁰⁶⁸⁷⁰⁸¹⁰/TEN-010/RG6146/JQ-35 (CAS No. 1349719-98-7), ZEN-3694 (CAS No. 1643947-30-1), CPI203 (CAS No. 1446144-04-2), PFI-1 (CAS No. 1403764-72-6), MS436 (Cas No. 1395084-25-9), RVX2135 (CAS No. 1253733-17-3), BAY-299 (CAS No. 2080306-23-4), GSK1324726A/I-BET726 (CAS No. 1300031-52-0), Molibresib/I-BET762/GSK525762 (CAS No. 1260907-17-2), RVX297 (CAS No. 1044871-04-6), SF1126 (CAS No. 936487-67-1), INCB054329 (CAS No. 1628607-64-6), INCB057643 (CAS No. 1820889-23-3), LY294002 (CAS No. 154447-36-6), AZD5153 (CAS No. 1869912-40-2), MT-1 (CAS No. 2060573-82-0), and MS645 (CAS No. 2250091-96-2) and analogues and derivatives thereof. Such compounds, or their agriculturally acceptable salts, may be useful in the present invention.

### C. Synthetic Methods

Compounds of the present disclosure may be prepared in a variety of ways using commercially available starting materials, compounds known in the literature, or from readily prepared intermediates, by employing standard synthetic methods and procedures either known to those skilled in the art, or which will be apparent to the skilled artisan in light of the teachings herein. Standard synthetic methods and procedures for the preparation of organic molecules and functional group transformations and manipulations may be obtained from the relevant scientific literature or from standard textbooks in the field. Although not limited to any one or several sources, classic texts such as Smith, M. B., March, J., March's Advanced Organic Chemistry: Reactions, Mechanisms, and Structure, 5.sup.th edition, John Wiley & Sons: New York, 2001; and Greene, T. W., Wuts. P. G. M., Protective Groups in Organic Synthesis, 3rd edition, John Wiley & Sons: New York, 1999, incorporated by reference herein, are useful and recognized reference textbooks of organic synthesis known to those in the art. The following descriptions of synthetic methods are designed to illustrate, but not to limit, general procedures for the preparation of compounds of the present disclosure. The processes generally provide the desired final compound at or near the end of the overall process, although it may be desirable in certain instances to further convert the compound to an agriculturally acceptable salt, ester or prodrug thereof. Suitable synthetic routes are depicted in the schemes herein.

Those skilled in the art will recognize if a stereocenter exists in the compounds disclosed herein. Accordingly, the present disclosure includes both possible stereoisomers (unless specified in the synthesis) and includes not only racemic compounds but the individual enantiomers and/or diastereomers as well. When a compound is desired as a single enantiomer or diastereomer, it may be obtained by stereospecific synthesis or by resolution of the final product or any convenient intermediate. Resolution of the final product, an intermediate, or a starting material may be affected by any suitable method known in the art. See, for example, “Stereochemistry of Organic Compounds” by E. L. Eliel, S. H. Wilen, and L. N. Mander (Wiley-Interscience, 1994).

The compounds of the present disclosure may be prepared in a number of ways well known to those skilled in the art of organic synthesis. By way of example, compounds of the present disclosure may be synthesized using the methods described below, together with synthetic methods known in the art of synthetic organic chemistry, or variations thereon as appreciated by those skilled in the art. Preferred methods include but are not limited to those methods described herein.

Non-limiting examples of protecting groups (e.g., N-terminal protecting groups) which may be employed for synthesis of the compounds provided herein include Fmoc, Boc, allyloxycarbonyl (Alloc), benzyloxycarbonyl (Z), and photolabile protecting groups. Sidechain protecting groups include, but are not limited to, Fmoc; Boc; cyclohexyloxycarbonyl (Hoc); allyloxycarbonyl (Alloc); mesityl-2-sulfonyl (Mts); 4-(N-methylamino)butanoyl (Nmbu); 2,4-dimethylpent-3-yloxycarbonyl (Doc); 1-(4,4-dimethyl-2,6-dioxocyclohex-1-ylidene)-3-ethyl (Dde); 1-(4,4-dimethyl-2,6-dioxocyclohex-1-ylidene)-3-methylbutyl (ivDde); 4-methyltrityl (Mtt). Additional protecting groups and methods for their addition and removal from peptides are described, for example, by Isidro-Llobet et al. Chem. Rev. 2009, 19: 2455-2504.

A base may be used to activate or complete the activation of amino acids prior to exposing the amino acids to reaction partners. Any suitable base may be used. In certain embodiments, the base is a Lewis base. In some embodiments, the base is a non-nucleophilic bases, such as triisopropylethylamine, N,N-diisopropylethylamine, certain tertiary amines, or collidine, that are non-reactive to or react slowly with protected peptides to remove protecting groups. In general, the base has a sufficient pKa to allow for deprotonation of the amino acid carboxylic acid.

A coupling agent may be used to form a bond with the carboxylate moiety of an amino acid to facilitate the coupling reaction and the formation of an amide bond. The coupling agent may be used to form activated amino acids before combination with a coupling partner (e.g., an amine) to produce the peptide product. Any suitable coupling agent may be used. In some embodiments, the coupling agent is a carbodiimide, a guanidinium salt, a phosphonium salt, or a uronium salt. Examples of carbodiimides include, but are not limited to, N,N′-dicyclohexylcarbodiimide (DCC), 1-ethyl-3-(3-dimethylaminopropyl)carbodiimide (EDC), and the like. Examples of phosphonium salts include, but are not limited to, (benzotriazol-1-yloxy)tripyrrolidino-phosphonium hexafluorophosphate (PyBOP), bromotris(dimethylamino)phosphonium hexafluorophosphate (BroP); and the like. Examples of guanidinium/uronium salts include, but are not limited to, O-(benzotriazol-1-yl)-N,N,N′,N′-tetramethyluronium hexafluorophosphate (HBTU); 2-(7-aza-1H-benzotriazole-1-yl)-1,1,3,3-tetramethyluronium hexafluorophosphate (HATU); 1-[(1-(cyano-2-ethoxy-2-oxoethylideneaminooxy) dimethylaminomorpholino)] uronium hexafluorophosphate (COMU); and the like. Other coupling agents such as propanephosphonic acid anhydride (T3P) may also be used.

While peptide bond formation may be conducted with a carboxylic acid (e.g., RC(O)OH), a base, and a coupling agent as described above, activated acid derivatives (e.g., RC(O)X, wherein X is a leaving group) may also be employed. Activated acid derivatives include, but are not limited to, anhydrides (including symmetric, mixed, or cyclic anhydrides), activated esters (e.g., p-nitrophenyl esters, pentafluorophenyl esters, N-succinimidyl esters, and the like), acylazoles (e.g., acylimidazoles, prepared using carbonyl diimidazole, and the like), acyl azides, and acid halides (e.g., acid chlorides).

In some instances, it may be advantageous to prepare particular products, or peptidic portions of such products, via solid-phase peptide synthesis. Non-limiting examples of support materials for solid-phase peptide synthesis include polystyrene (e.g., microporous polystyrene resin, mesoporous polystyrene resin, macroporous polystyrene resin; including commercially available Wang resins, Rink amide resins, and trityl resins), glass, polysaccharides (e.g., cellulose, agarose), polyacrylamide resins, polyethylene glycol, or copolymer resins (e.g., comprising polyethylene glycol, polystyrene, etc.). The solid support may have any suitable form factor. For example, the solid support may be in the form of beads, particles, fibers, or in any other suitable form factor.

### D. Applications in Insects and Insect Cells

In another aspect, the disclosure provides methods for controlling a level of a target protein that is expressed in an insect cell. The target protein can be, for example, any of the insect proteins of interest described in Section B.3. The methods generally include contacting the insect cell with an effective amount of any of the bifunctional compounds, e.g., PROTAC compound, described herein. For example, the bifunctional compound can have one or more protein targeting moieties covalently bonded via a linker to one or more ligase targeting moieties, where the ligase targeting moieties can have the chemical structure of any of the formulas provided herein. In some embodiments, the ligase targeting moiety has a structure according to any one of the formulas described in Section B.1, the linker is any of those described in Section B.2, and/or the protein targeting moiety is any of those described in Section B.3. In some embodiments, the compound contacted with the insect cell includes one or more compounds having any of the structures set forth in Tables 1-3 of the Examples.

The effective amount of the compound contacted with the insect cell in the provided methods for controlling a target protein level can be a pesticidally effective amount, referred to herein as an effective amount. An “effective amount” is an amount of a compound that causes the death of at least one pest (i.e., insect) or that noticeably reduces pest growth, feeding, or normal physiological development. This amount will vary depending on such factors as, for example, the specific target pests to be controlled, the specific environment, location, plant, crop, or agricultural site to be treated, the environmental conditions, and the method, rate, concentration, stability, and quantity of application of the compound. Decreases in pest numbers, pest growth, pest feeding or pest normal development resulting from contact with an effective amount of a provided compound can include any statistically significant decrease. For example, an effective amount of a provided compound can cause an insect growth, feeding, and/or development decrease of about 5%, 10%, 15%, 20%, 25%, 30%, 35%, 40%, 45%, 50%, 55%, 60%, 65%, 70%, 75%, 85%, 90%, 95% or greater.

In general, contacting an insect cell with an effective amount of a provided compound controls a level of a target protein by inducing degradation of the target protein within the insect cell. For example, the amount of the compound contacted with the insect cell may induce degradation of the target protein, where the degradation has an effective degradation efficiency. An effective degradation efficiency may be one having a DC₅₀ and/or Dₘₐₓ satisfying a particular cutoff Exemplary values of DC₅₀ and Dₘₐₓ indicating effective degradation efficiency can be any of those described in Section B of this disclosure.

The bifunctional compounds disclosed herein display activity against a variety of insect pests, which may include economically important agronomic, forest, greenhouse, nursery, ornamentals, food and fiber, public and animal health, domestic and commercial structure, household, and stored product pests. Insect pests include insects selected from the orders Coleoptera, Diptera, Hymenoptera, Lepidoptera, Mallophaga, Homoptera, Hemiptera, Orthoptera, Thysanoptera, Dermaptera, Isoptera, Anoplura, Siphonaptera, Trichoptera, etc., particularly Lepidoptera.

Insects of the order Coleoptera affected by the provided compounds include weevils from the families Anthribidae, Bruchidae, and Curculionidae (including, but not limited to: Anthonomus grandis (boll weevil); Lissorhoptrus oryzophilus (rice water weevil); Sitophilus granarius (granary weevil); S. oryzae (rice weevil); Hypera punctata (clover leaf weevil); Cylindrocopturus adspersus (sunflower stem weevil); Smicronyx fulvus (red sunflower seed weevil); S. sordidus (gray sunflower seed weevil); Sphenophorus maidis (maize billbug)); flea beetles, cucumber beetles, rootworms, leaf beetles, potato beetles, and leafminers in the family Chrysomelidae (including, but not limited to: Leptinotarsa decemlineata (Colorado potato beetle); Diabrotica virgifera virgifera (western corn rootworm); D. barberi (northern corn rootworm); D. undecimpunctata howardi (southern corn rootworm); Chaetocnema pulicaria (corn flea beetle); Phyllotreta cruciferae (corn flea beetle); Colaspis brunnea (grape colaspis); Oulema melanopus (cereal leaf beetle); Zygogramma exclamationis (sunflower beetle)); beetles from the family Coccinellidae (including, but not limited to: Epilachna varivestis (Mexican bean beetle)); chafers and other beetles from the family Scarabaeidae (including, but not limited to: Popillia japonica (Japanese beetle); Cyclocephala borealis (northern masked chafer, white grub); C. immaculata (southern masked chafer, white grub); Rhizotrogus majalis (European chafer); Phyllophaga crinita (white grub); Ligyrus gibbosus (carrot beetle)); carpet beetles from the family Dermestidae; wireworms from the family Elateridae, Eleodes spp., Melanotus spp.; Conoderus spp.; Limonius spp.; Agriotes spp.; Ctenicera spp.; Aeolus spp.; bark beetles from the family Scolytidae; and beetles from the family Tenebrionidae.

Insects of the order Lepidoptera affected by the provided compounds include, but are not limited to, armyworms, cutworms, loopers, and heliothines in the family Noctuidae Spodoptera frugiperda (fall armyworm); S. exigua (beet armyworm); S. litura (tobacco cutworm, cluster caterpillar); Mamestra configurata (bertha armyworm); M. brassicae (cabbage moth); Agrotis ipsilon (black cutworm); A. orthogonia (western cutworm); A. subterranea (granulate cutworm); Alabama argillacea (cotton leaf worm); Trichoplusia ni (cabbage looper); Pseudoplusia includens (soybean looper); Anticarsia gemmatalis (velvetbean caterpillar); Hypena scabra (green cloverworm); Heliothis virescens (tobacco budworm); Pseudaletia unipuncta (armyworm); Athetis mindara (rough skinned cutworm); Euxoa messoria (darksided cutworm); Earias insulana (spiny bollworm); E. vittella (spotted bollworm); Helicoverpa armigera (American bollworm); H. zea (corn earworm or cotton bollworm); Melanchra picta (zebra caterpillar); Egira (Xylomyges) curialis (citrus cutworm); borers, casebearers, webworms, coneworms, and skeletonizers from the family Pyralidae Ostrinia nubilalis (European corn borer); Amyelois transitella (naval orangeworm); Anagasta kuehniella (Mediterranean flour moth); Cadra cautella (almond moth); Chilo suppressalis (rice stem borer); C. partellus, (sorghum borer); Corcyra cephalonica (rice moth); Crambus caliginosellus (corn root webworm); C. teterrellus (bluegrass webworm); Cnaphalocrocis medinalis (rice leaf roller); Desmiafuneralis (grape leaffolder); Diaphania hyalinata (melon worm); D. nitidalis (pickleworm); Diatraea grandiosella (southwestern corn borer), D. saccharalis (surgarcane borer); Eoreuma loftini (Mexican rice borer); Ephestia elutella (tobacco (cacao) moth); Galleria mellonella (greater wax moth); Herpetogramma licarsisalis (sod webworm); Homoeosoma electellum (sunflower moth); Elasmopalpus lignosellus (lesser cornstalk borer); Achroia grisella (lesser wax moth); Loxostege sticticalis (beet webworm); Orthaga thyrisalis (tea tree web moth); Maruca testulalis (bean pod borer); Plodia interpunctella (Indian meal moth); Scirpophaga incertulas (yellow stem borer); Udea rubigalis (celery leaftier); and leafrollers, budworms, seed worms, and fruit worms in the family Tortricidae Acleris gloverana (Western blackheaded budworm); A. variana (Eastern blackheaded budworm); Archips argyrospila (fruit tree leaf roller); A. rosana (European leaf roller); and other Archips species, Adoxophyes orana (summer fruit tortrix moth); Cochylis hospes (banded sunflower moth); Cydia latiferreana (filbertworm); C. pomonella (coding moth); Platynota flavedana (variegated leafroller); P. stultana (omnivorous leafroller); Lobesia botrana (European grape vine moth); Spilonota ocellana (eyespotted bud moth); Endopiza viteana (grape berry moth); Eupoecilia ambiguella (vine moth); Bonagota salubricola (Brazilian apple leafroller); Grapholita molesta (oriental fruit moth); Suleima helianthana (sunflower bud moth); Argyrotaenia spp.; and Choristoneura spp.

Insects in the order Lepidoptera affected by the provided compounds further include, but are not limited to, Alsophila pometaria (fall cankerworm); Anarsia lineatella (peach twig borer); Anisota senatoria (orange striped oakworm); Antheraea pernyi (Chinese Oak Silkmoth); Bombyx mori (Silkworm); Bucculatrix thurberiella (cotton leaf perforator); Colias eurytheme (alfalfa caterpillar); Datana integerrima (walnut caterpillar); Dendrolimus sibiricus (Siberian silk moth), Ennomos subsignaria (elm spanworm); Erannis tiliaria (linden looper); Euproctis chrysorrhoea (browntail moth); Harrisina americana (grapeleaf skeletonizer); Hemileuca oliviae (range caterpillar); Hyphantria cunea (fall webworm); Keiferia lycopersicella (tomato pinworm); Lambdina fiscellaria fiscellaria (Eastern hemlock looper); L. fiscellaria lugubrosa (Western hemlock looper); Leucoma salicis (satin moth); Lymantria dispar (gypsy moth); Manduca quinquemaculata (five spotted hawk moth, tomato hornworm); M. sexta (tomato hornworm, tobacco hornworm); Operophtera brumata (winter moth); Paleacrita vernata (spring cankerworm); Papilio cresphontes (giant swallowtail, orange dog); Phryganidia californica (California oakworm); Phyllocnistis citrella (citrus leafminer); Phyllonorycter blancardella (spotted tentiform leafminer); Pieris brassicae (large white butterfly); P. rapae (small white butterfly); P. napi (green veined white butterfly); Platyptilia carduidactyla (artichoke plume moth); Plutella xylostella (diamondback moth); Pectinophora gossypiella (pink bollworm); Pontia protodice (Southern cabbageworm); Sabulodes aegrotata (omnivorous looper); Schizura concinna (red humped caterpillar); Sitotroga cerealella (Angoumois grain moth); Thaumetopoea pityocampa (pine processionary caterpillar); Tineola bisselliella (webbing clothesmoth); Tuta absoluta (tomato leafminer); Yponomeuta padella (ermine moth); Heliothis subflexa; Malacosoma spp. and Orgyia spp.

Immature insects of the order Diptera affected by the provided compounds include leafminers such as Agromyza parvicornis (corn blotch leafminer); midges (including, but not limited to, Contarinia sorghicola (sorghum midge); Mayetiola destructor (Hessian fly); Sitodiplosis mosellana (wheat midge); Neolasioptera murtfeldtiana, (sunflower seed midge)); fruit flies (Tephritidae), Oscinella frit (frit flies); maggots (including, but not limited to: Delia platura (seedcorn maggot); D. coarctata (wheat bulb fly); and other Delia spp., Meromyza americana (wheat stem maggot); Musca domestica (house flies); Fannia canicularis, F. femoralis (lesser house flies); Stomoxys calcitrans (stable flies)); face flies, hom flies, blow flies, Chrysomya spp.; Phormia spp.; and other muscoid fly pests, horse flies Tabanus spp.; bot flies Gastrophilus spp.; Oestrus spp.; cattle grubs Hypodernia spp.; deer flies Chrysops spp.; Melophagus ovinus (keds); and other Brachycera, mosquitoes Aedes spp. (including, but not limited to, A. aegypti and A. albopictus); Anopheles spp. (including, but not limited to, An. gambiae, An. quadrimaculatus and An. stephensi); Culex spp.; black flies Prosimulium spp.; Simulium spp.; biting midges, sand flies, sciarids, and other Nematocera.

Insects of the orders Hemiptera and Homoptera affected by the provided compounds include insects such as, but not limited to, adelgids from the family Adelgidae, plant bugs from the family Miridae, cicadas from the family Cicadidae, leafhoppers, Empoasca spp.; from the family Cicadellidae, planthoppers from the families Cixiidae, Flatidae, Fulgoroidea, Issidae and Delphacidae, treehoppers from the family Membracidae, psyllids from the family Psyllidae, whiteflies from the family Aleyrodidae, aphids from the family Aphididae, Phylloxera from the family Phylloxeridae, mealybugs from the family Pseudococcidae, scales from the families Asterolecanidae, Coccidae, Dactylopiidae, Diaspididae, Eriococcidae, Ortheziidae, Phoenicococcidae and Margarodidae, lace bugs from the family Tingidae, stink bugs from the family Penlatomidae, cinch bugs, Blissus spp.; and other seed bugs from the family Lygaeidae, spittlebugs from the family Cercopidae squash bugs from the family Coreidae, and red bugs and cotton stainers from the family Pyrrhocoridae.

Agronomically important members from the order Homoptera affected by the provided compounds further include, but are not limited to: Acyrthisiphon pisum (pea aphid); Aphis craccivora (cowpea aphid); A. fabae (black bean aphid); A. gossypii (cotton aphid, melon aphid); A. maidiradicis (corn root aphid); A. pomi (apple aphid); A. spiraecola (spirea aphid); Aulacorthum solani (foxglove aphid); Chaetosiphon fragaefolii (strawberry aphid); Diuraphis noxia (Russian wheat aphid); Dysaphis plantaginea (rosy apple aphid); Eriosoma lanigerum (woolly apple aphid); Brevicoryne brassicae (cabbage aphid); Hyalopterus pruni (mealy plum aphid); Lipaphis erysimi (turnip aphid); Metopolophium dirrhodum (cereal aphid); Macrosiphum euphorbiae (potato aphid); Myzus persicae (peach-potato aphid, green peach aphid); Nasonovia ribisnigri (lettuce aphid); Pemphigus spp. (root aphids and gall aphids); Rhopalosiphum maidis (corn leaf aphid); R. padi (bird cherry-oat aphid); Schizaphis graminum (greenbug); Sipha flava (yellow sugarcane aphid); Sitobion avenae (English grain aphid); Therioaphis maculata (spotted alfalfa aphid); Toxoptera aurantii (black citrus aphid); and T. citricida (brown citrus aphid); Adelges spp. (adelgids); Phylloxera devastatrix (pecan phylloxera); Bemisia tabaci (tobacco whitefly, sweetpotato whitefly); B. argentifolii (silverleaf whitefly); Dialeurodes citri (citrus whitefly); Trialeurodes abutiloneus (banded winged whitefly) and T. vaporariorum (greenhouse whitefly); Empoasca fabae (potato leafhopper); Laodelphax striatellus (smaller brown planthopper); Macrolestes quadrilineatus (aster leafhopper); Nephotettix cinticeps (green leafhopper); N. nigropictus (rice leafhopper); Nilaparvata lugens (brown planthopper); Peregrinus maidis (corn planthopper); Sogatella furcifera (white-backed planthopper); Sogatodes orizicola (rice delphacid); Typhlocyba pomaria (white apple leafhopper); Erythroneoura spp. (grape leafhoppers); Magicicada septendecim (periodical cicada); Icerya purchasi (cottony cushion scale); Quadraspidiotus perniciosus (San Jose scale); Planococcus citri (citrus mealybug); Pseudococcus spp. (other mealybug complex); Cacopsylla pyricola (pear psylla); and Trioza diospyri (persimmon psylla).

Agronomically important species from the order Hemiptera affected by the provided compounds include, but are not limited to: Acrosternum hilare (green stink bug); Anasa tristis (squash bug); Blissus leucopterus leucopterus (chinch bug); Corythuca gossypii (cotton lace bug); Cyrtopeltis modesta (tomato bug); Dysdercus suturellus (cotton stainer); Euschistus servus (brown stink bug); E. variolarius (one-spotted stink bug); Graptostethus spp. (complex of seed bugs); Leptoglossus corculus (leaf-footed pine seed bug); Lygus lineolaris (tarnished plant bug); L. Hesperus (Western tarnished plant bug); L. pratensis (common meadow bug); L. rugulipennis (European tarnished plant bug); Lygocoris pabulinus (common green capsid); Nezara viridula (southern green stink bug); Oebalus pugnax (rice stink bug); Oncopeltus fasciatus (large milkweed bug); Pseudatomoscelis seriatus (cotton fleahopper). Insects included in the order Hemiptera include: Calocoris norvegicus (strawberry bug); Orthops campestris; Plesiocoris rugicollis (apple capsid); Cyrtopeltis modestus (tomato bug); Cyrtopeltis notatus (suckfly); Spanagonicus albofasciatus (whitemarked fleahopper); Diaphnocoris chlorionis (honeylocust plant bug); Labopidicola allii (onion plant bug); Pseudatomoscelis seriatus (cotton flea hopper); Adelphocoris rapidus (rapid plant bug); Poecilocapsus lineatus (four-lined plant bug); Nysius ericae (false chinch bug); Nysius raphanus (false chinch bug); Nezara viridula (Southern green stink bug); Eurygaster spp.; Coreidae spp.; Pyrrhocoridae spp.; Timidae spp.; Blostomatidae spp.; Reduviidae spp.; and Cimicidae spp.

Insects of the order Acari (mites) affected by the provided compounds include Aceria tosichella (wheat curl mite); Petrobia latens (brown wheat mite); spider mites and red mites in the family Tetranychidae, Panonychus ulmi (European red mite); Tetranychus urticae (two spotted spider mite); (T. mcdanieli (McDaniel mite); T. cinnabarinus (carmine spider mite); T. turkestani (strawberry spider mite); flat mites in the family Tenuipalpidae, Brevipalpus lewisi (citrus flat mite); rust and bud mites in the family Eriophyidae and other foliar feeding mites and mites important in human and animal health, i.e., dust mites in the family Epidermoptidae, follicle mites in the family Demodicidae, grain mites in the family Glycyphagidae, ticks in the order Ixodidae. Ixodes scapularis (deer tick); I. holocyclus (Australian paralysis tick); Dermacentor variabilis (American dog tick); Amblyomma americanum (lone star tick); and scab and itch mites in the families Psoroptidae, Pyemotidae, and Sarcoptidae.

Insect pests of the order Thysanura affected by the provided compounds include Lepisma saccharina (silverfish); Thermobia domestics (firebrat). Additional arthropod pests include: spiders in the order Araneae such as Loxosceles reclusa (brown recluse spider); and the Latrodectus mactans (black widow spider); and centipedes in the order Scutigeromorpha such as Scutigera coleoptrata (house centipede).

The pesticidal activity of the compositions disclosed herein may be tested in insect pests in their early developmental stages, e.g., as larvae or other immature forms. A wide variety of bioassay techniques are known to one skilled in the art. General procedures include addition of the experimental compound or organism to the diet source in an enclosed container. Bioassays may be performed as described in Czapla and Lang (1990) J. Econ. Entomol. 83 (6): 2480-2485, Andrews et al., (1988) Biochem. J. 252:199-206; Marrone et al., (1985) J. of Economic Entomology 78:290-293 and U.S. Pat. No. 5,743,477, all of which are herein incorporated by reference in their entirety. Generally, the protein is mixed and used in feeding assays. See, for example Marrone et al., (1985) J. of Economic Entomology 78:290-293. Methods of rearing insect larvae and performing bioassays are well known to one of ordinary skill in the art. Measurable indicia of pesticidal activity include, but are not limited to, changes in mortality, weight loss, attraction, repellency, and other behavioral and physical changes after feeding and exposure for an appropriate length of time. See, for example U.S. Pat. No. 7,619,064.

### E. Compositions

The bifunctional compounds disclosed herein may be formulated into compositions for use. Such compositions comprise one or more provided bifunctional compounds, and one or more agriculturally acceptable carriers, surfactants or application-promoting adjuvants customarily employed in the art of formulation. As used herein, the term “agriculturally-acceptable carrier” covers all adjuvants, inert components, dispersants, surfactants, tackifiers, binders, etc. that are ordinarily used in pesticide formulation technology; these are well known to those skilled in pesticide formulation. Suitable carriers and adjuvants may be solid or liquid and correspond to the substances ordinarily employed in formulation technology, e.g., natural or regenerated mineral substances, solvents, dispersants, wetting agents, tackifiers, binders or the like. The compositions may comprise more than one type of bifunctional compound, as well as additional agents, such as insecticides, fertilizers, herbicides, and plant supplements. Likewise, the formulations may be prepared into edible “baits” or fashioned into pest “traps” to permit feeding or ingestion by a target pest of the pesticidal formulation.

The compositions may be applied to the environment of an insect pest by, for example, spraying, atomizing, dusting, scattering, coating or pouring, introducing into or on the soil, introducing into irrigation water, by seed treatment or general application or dusting at the time when the pest has begun to appear or before the appearance of pests as a protective measure. For example, the provided compositions may be mixed with grain to protect the grain during storage. It is generally important to obtain good control of pests in the early stages of plant growth, as this is the time when the plant may be most severely damaged. Provided embodiments include granular forms of the composition comprising an agrochemical such as, for example, an herbicide, an insecticide, a fertilizer, an inert carrier, and the like.

Also provided are methods of applying an active ingredient or a composition where the active ingredient or composition contains at least one of the bifunctional compounds disclosed herein. In some embodiments, the methods include application to the insect pests, application to the plant or plant locus, e.g., leaf application, seed coating and soil application, or application to other surfaces in the environment in which the insect is present. The number of applications and the rate of application depend on the intensity of infestation by the corresponding pest.

In some embodiments, the composition is formulated as a powder, dust, pellet, granule, spray, emulsion, colloid, solution or the like. In some embodiments, the composition is prepared by desiccation, lyophilization, homogenization, extraction, filtration, centrifugation, sedimentation, or concentration. In some embodiments, the bifunctional compounds is present in a concentration of from about 1% to about 99% by weight, e.g., from about 1 wt % to about 60 wt %, from about 10 wt % to about 70 wt %, from about 20 wt % to about 80 wt %, from about 30 wt % to about 90 wt %, or from about 40 wt % to about 100 wt %.

In some embodiments, the composition is applied to any plant species for control of a pest. Plants of interest include grain plants that provide seeds of interest, oil-seed plants, leguminous plants, vegetables, ornamentals, trees, turfgrass, and the like. Seeds of interest include grain seeds, such as corn, wheat, barley, rice, sorghum, rye, millet, etc. Oil-seed plants include cotton, soybean, safflower, sunflower, Brassica, maize, alfalfa, palm, coconut, flax, castor, olive etc. Leguminous plants include beans and peas. Beans include guar, locust bean, fenugreek, soybean, garden beans, cowpea, mungbean, lima bean, fava bean, lentils, chickpea, etc. It is recognized that the provided compositions and compounds may be applied to the surface of the plant. Some of the bifunctional compounds may be taken up by the plant. In any event, the compounds are accessible to insect pest by feeding on the plants.

Examples of plants of interest include, but are not limited to, corn (Zea mays), Brassica sp. (e.g., B. napus, B. rapa, B. juncea), particularly those Brassica species useful as sources of seed oil, alfalfa (Medicago sativa), rice (Oryza sativa), rye (Secale cereale), sorghum (Sorghum bicolor, Sorghum vulgare), millet (e.g., pearl millet (Pennisetum glaucum), proso millet (Panicum miliaceum), foxtail millet (Setaria italica), finger millet (Eleusine coracana)), sunflower (Helianthus annuus), safflower (Carthamus tinctorius), wheat (Triticum aestivum), soybean (Glycine max), tobacco (Nicotiana tabacum), potato (Solanum tuberosum), peanuts (Arachis hypogaea), cotton (Gossypium barbadense, Gossypium hirsutum), sweet potato (Ipomoea batatus), cassaya (Manihot esculenta), coffee (Coffea spp.), coconut (Cocos nucifera), pineapple (Ananas comosus), citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), cashew (Anacardium occidentale), macadamia (Macadamia integrifolia), almond (Prunus amygdalus), sugar beets (Beta vulgaris), sugarcane (Saccharum spp.), oats, barley, vegetables, ornamentals, and conifers.

### F. Exemplary Embodiments

The following embodiments are contemplated. All combinations of features and embodiments are contemplated.

Embodiment 1: A method of controlling a level of a target protein that is expressed in an insect cell, the method comprising contacting the insect cell with an effective amount of a compound, the compound comprising: one or more protein targeting moieties (PTM) that each independently bind the target protein; one or more ligase targeting moieties (LTM) that each independently bind a ubiquitin ligase that is functional in the insect cell; and a linker (L) covalently bonded to the one or more protein targeting moieties and the one or more ligase targeting moieties.

Embodiment 2: An embodiment of embodiment 1, wherein the ubiquitin ligases that the one or more ligase targeting moieties bind to comprise the von Hippel-Lindau tumor suppressor (VHL) or cereblon.

Embodiment 3: An embodiment of embodiment 1 or 2, wherein at least one of the one or more ligase targeting moieties has a structure according to the formula:

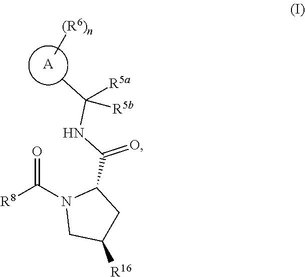

wherein R^{5a} and R^{5b} are each independently hydrogen, hydroxyl, amine, haloalkyl, optionally substituted alkyl, optionally substituted alkoxy, optionally substituted hydroxyl alkyl, optionally substituted alkylamine, optionally substituted amide, optionally substituted alkyl-amide, optionally substituted alkyl-cyano, optionally substituted alkyl-phosphate, optionally substituted aryl, optionally substituted alkyl-aryl, optionally substituted heteroalkyl, optionally substituted alkyl-heterocyclyl, optionally substituted alkoxy-heterocyclyl, COR¹⁴, alkyl-COR¹⁴, CONR^{15a}R^{15b}, NHCOR¹⁴, NHCH₃COR¹⁴, or —X-L¹, or are combined with the carbon atom to which they are attached to form an optionally substituted 3- to 5-membered cycloalkyl, heterocyclyl, spirocycloalkyl, or spiroheterocyclyl, wherein the spiroheterocyclyl is not epoxide or aziridine; each R⁶ is independently C₁₋₆ alkyl, halogen, C₁₋₆ haloalkyl, hydroxy, C₁₋₆ alkoxy, C₁₋₆ haloalkoxy, C₃₋₈ cycloalkyl, C₆₋₁₂ aryl, C₅₋₁₂ heteroaryl, C₃₋₁₅ heterocyclyl, cyano, nitro, NR^{15a}R^{15b}, OR¹⁴, CONR^{15a}R^{15b}, NR^{15a}COR^{15b}, SO₂NR^{15a}R^{15b}, NR^{15a} SO₂R^{15b}, or —X-L¹, wherein the alkyl, haloalkyl, alkoxy, cycloalkyl, aryl, heteroaryl, and heterocyclyl are optionally substituted with 1 to 4 R^{6a} groups; R⁸ is an optionally substituted aryl, optionally substituted heteroaryl, or

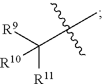

R⁹ and R¹⁰ are independently hydrogen, optionally substituted alkyl, optionally substituted cycloalkyl, optionally substituted hydroxyalkyl, optionally substituted heteroaryl, haloalkyl, or

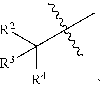

or are combined with the carbon atom to which they are attached to form an optionally substituted cycloalkyl; R² and R³ are each independently hydrogen, C₁₋₆ alkyl, or C₁₋₆ hydroxyalkyl, or are combined with the carbon to which they are attached to form a C₃₋₈ cycloalkyl, C₆₋₁₂ aryl, or C₅₋₁₂ heteroaryl, wherein the cycloalkyl, aryl and heteroaryl are optionally substituted with 1 to 4 R^{2a} groups; R⁴ is hydrogen, C₁₋₆ alkyl, C₁₋₆ hydroxyalkyl, or —X-L¹; R₁₁ is an optionally substituted heterocyclyl, optionally substituted alkoxy, optionally substituted heteroaryl, optionally substituted aryl,

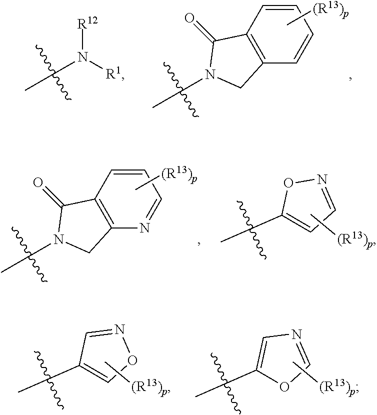

R¹ is hydrogen, optionally substituted alkyl, optionally substituted alkylcarbonyl, optionally substituted (cycloalkyl)alkylcarbonyl, optionally substituted aralkylcarbonyl, optionally substituted arylcarbonyl, optionally substituted (heterocyclyl)carbonyl, optionally substituted aralkyl, —C(O)R^{1a}, or —C(O)—X-L¹; R^{1a} is C₁₋₆ alkyl, C₃₋₈ cycloalkyl, C₆₋₁₂ aryl, or C₅₋₁₂ heteroaryl, wherein the cycloalkyl, aryl, and heteroaryl are optionally substituted with 1 to 4 R^{1b} groups; each R^{1b}, R^{2a}, and R^{6a} is independently C₁₋₆ alkyl, cyano, halogen, C₁₋₆ haloalkyl, hydroxy, C₁₋₆ alkoxy, C₁₋₆ haloalkoxy, or —X-L¹; R¹² is hydrogen or optionally substituted alkyl; each R¹³ is independently hydrogen, halogen, optionally substituted alkoxy, cyano, optionally substituted alkyl, haloalkyl, haloalkoxy, or —X-L¹; each R¹⁴ is independently hydrogen, OH, O—C₁₋₆ alkyl, optionally substituted alkyl, or NR^{15a}R^{15b}; R^{15a} and R^{15b} are each independently hydrogen, optionally substituted alkyl, or optionally substituted cycloalkyl, or are combined with the nitrogen atom to which they are attached to form a 4- to 6-membered heterocyclyl; R¹⁶ is hydroxy, a group that can be metabolized to hydroxy, or sulfonyl halide; A is optionally substituted phenyl, optionally substituted napthyl, or an optionally substituted 5- to 10-membered heteroaryl; X is a bond, CH₂, NH, NMe, O, or S; L¹ is a site of attachment to the linker; and the subscripts n and p are each independently an integer from 0 to 4.

Embodiment 4: An embodiment of embodiment 3, wherein at least one of the one or more ligase targeting moieties has a structure according to the formula:

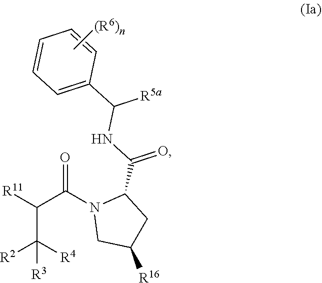

wherein R¹ is hydrogen, C₁₋₆ alkyl, —C(O)R^{1a}, or —C(O)—X-L¹; R⁴ is hydrogen, C₁₋₆ alkyl, C₁₋₆ hydroxyalkyl, or —X-L¹; R^{5a} is hydrogen, C₁₋₆ alkyl, halogen, C₁₋₆ haloalkyl, C₁₋₆ alkyl-amide, hydroxy, C₁₋₆ alkoxy, C₁₋₆ haloalkoxy or —X-L¹; and each R⁶ is independently C₁₋₆ alkyl, halogen, C₁₋₆ haloalkyl, hydroxy, C₁₋₆ alkoxy, C₁₋₆ haloalkoxy, C₃₋₈ cycloalkyl, C₆₋₁₂ aryl, C₅₋₁₂ heteroaryl, OR¹⁴, or —X-L¹, wherein the cycloalkyl, aryl, and heteroaryl are optionally substituted with 1 to 4 R^{6a} groups.

Embodiment 5: An embodiment of embodiment 3 or 4, wherein R¹ is —C(O)R^{1a} or —C(O)—X-L¹; and R^{1a} is C₁₋₆ alkyl or C₃₋₈ cycloalkyl, wherein the cycloalkyl is optionally substituted with 1 to 4 R^{1b} groups.

Embodiment 6: An embodiment of any one of embodiments 3-5, wherein R² and R³ are each independently C₁₋₆ alkyl.

Embodiment 7: An embodiment of any one of embodiments 3-6, wherein R⁴ is C₁₋₆ alkyl or —X-L¹.

Embodiment 8: An embodiment of any one of embodiments 3-7, wherein R^{5a} is hydroxy or methyl.

Embodiment 9: An embodiment of any one of embodiments 3-8, wherein each R⁶ is independently C₅₋₁₂ heteroaryl or —X-L¹, wherein the heteroaryl is optionally substituted with 1 to 4 R^{6a} groups; and each R^{6a} is independently C₁₋₆ alkyl.

Embodiment 10: An embodiment of embodiment 9, wherein each R⁶ is independently thiazole or —X-L¹, wherein the thiazole is optionally substituted with 1 to 4 R^{6a} groups.

Embodiment 11: An embodiment of any one of embodiments 3-10, wherein subscript n is 1 or 2.

Embodiment 12: An embodiment of any one of embodiments 3-11, wherein at least one of the one or more ligase targeting moieties has a structure according to the formula:

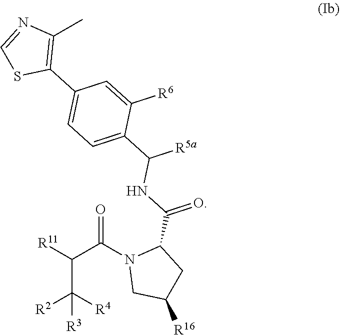

Embodiment 13: An embodiment of embodiment 12, wherein at least one of the one or more ligase targeting moieties has the structure:

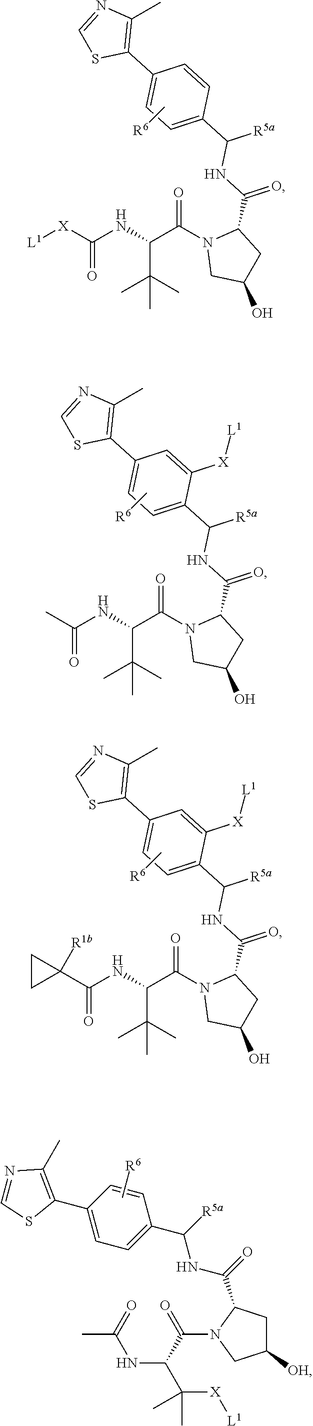

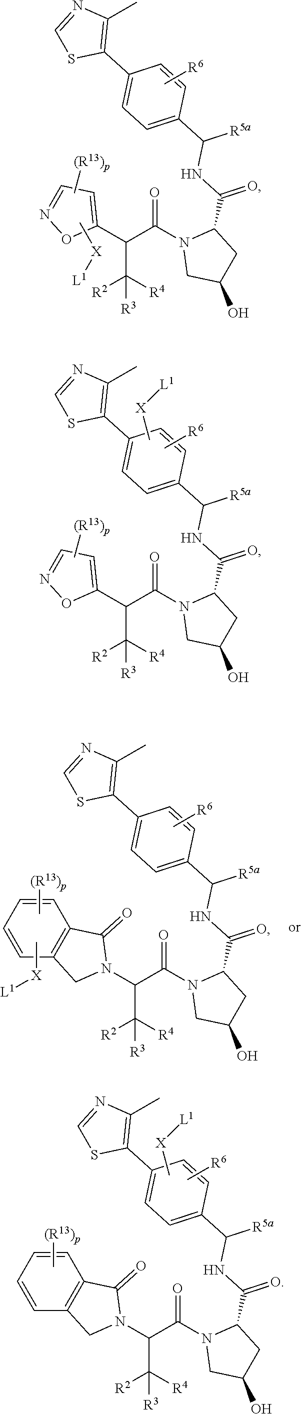

Embodiment 14: An embodiment of embodiment 1 or 2, wherein at least one of the one or more ligase targeting moieties comprises an N-substituted 1,3,-dioxoisoindolinyl moiety optionally substituted with one or more substituents that are each independently C₁₋₆ alkyl, halogen, hydroxy, amino, C₁₋₆ alkylamino, C₁₋₆ amido, C₁₋₆ acyl, nitro, cyano, or C₁₋₆ alkoxy.

Embodiment 15: An embodiment of any one of embodiments 1-14, wherein the linker has a linear non-hydrogen atom number from 1 to 20.

Embodiment 16: An embodiment of any one of embodiments 1-15, wherein the linker has a structure -L²-L³-, wherein L² and L³ are each independently a bond, a divalent polymer moiety, or C₁₋₃₀ alkylene, wherein one or more carbon atoms in each C₁₋₃₀ alkylene are optionally and independently replaced by O, C(O), S, or NR⁷; one or more groupings of adjacent carbon atoms in each C₁₋₃₀ alkylene are optionally and independently replaced by —NR⁷(CO)— or —(CO)NR⁷—; and one or more groupings of adjacent carbon atoms in each C₁₋₃₀ alkylene are optionally and independently replaced by a 4- to 8-membered, divalent carbocycle or a 4- to 8-membered, divalent heterocycle having one to four heteroatoms selected from O, S, and N; and each R⁷ is independently hydrogen or C₁₋₆ alkyl.

Embodiment 17: An embodiment of any one of embodiments 1-16, wherein the linker comprises one or more ethylene glycol diradical moieties, one or more of which is optionally replaced by the moiety:

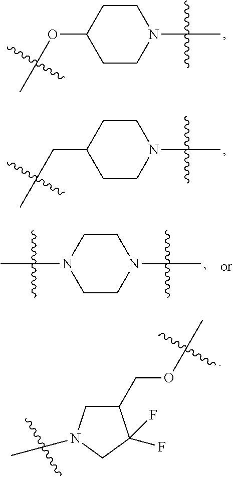 [SMILES: *OC1CCN(*)CC1 ; *CC1CCN(*)CC1 ; *N1CCN(*)CC1 ; *OCC1CN(*)CC1(F)F]

Embodiment 18: An embodiment of any one of embodiments 1-17, wherein at least one of the one or more protein targeting moieties has the structure:

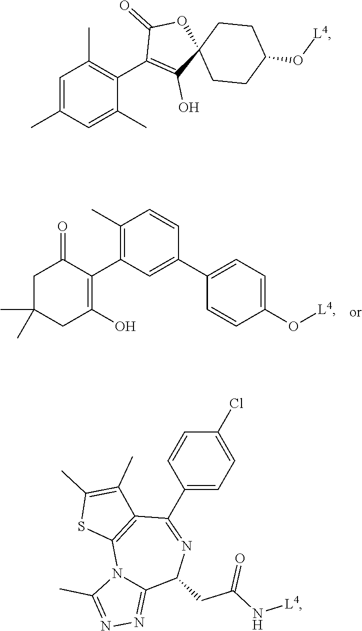

wherein L⁴ is a site of attachment to the linker.

Embodiment 19: An embodiment of any one of embodiments 1-18, wherein the proteins that the one or more protein targeting moieties bind to are essential to growth, development, reproduction, or survival of the insect.

Embodiment 20: An embodiment of embodiment 19, wherein the proteins comprise acetyl CoA carboxylase, acetylcholinesterase, GABA-gated chloride channels, sodium channels, nicotinic acetylcholine receptors, glutamate-gated chloride channels, chordontal organ TRPV channels, chitin synthase, mitochondrial ATP synthase, ecdysone receptors, octopamine receptors, voltage-dependent sodium channels, ryanodine receptors, calcium-activated potassium channels, juvenile hormone receptors, Bromaindomain Containing 3 (BRD3), chitin acetyltransferase, Cholone O-Acetyltransferase (ChAT), Dihydrofolate Reductase (DHFR), FK506 binding proteins (FKBP), Geranylgeranyl diphosphate synthase 1 (GGPS1), 3-Hydroxy-3Methylglutaryl-CoA Reductase (HMGCR), Inosine-5′-monophosphate dehydrogenase (IMPDH), Juvenile hormone acid O-methyltranserase (JHAMT), lysine-tRNA ligase (KRS1), MET Proto-Oncogene, Receptor Tyrosine Kinase (MET), Thioredoxin reductase (TXNRD), N-myristoyl transferase (NMT), SWI/SNF Related, Matrix Associated, Actin Dependent Regulator of Chromatin, Subfamily A, Member 2 (SMARCA2), USP and Will Die Slowly (WDS) or a combination thereof.

Embodiment 21: An embodiment of embodiment 20, wherein the proteins comprise Bromaindomain Containing 3 (BRD3) or Will Die Slowly (WDS).

Embodiment 22: An embodiment of any one of embodiments 1-21, wherein the insect cell is a cell of an insect that is a member of the order Lepidoptera, Coleoptera, Diptera, Hymenoptera, Mallophaga, Homoptera, Hemiptera, Orthoptera, Thysanoptera, Dermaptera, Isoptera, Anoplura, Siphonaptera, or Trichoptera.

Embodiment 23: An embodiment of embodiment 22, wherein the insect is a member of the order Lepidoptera.

Embodiment 24: A composition comprising the compound of any one of embodiments 1-23, or a salt or solvate thereof, and an agriculturally acceptable carrier.

Embodiment 25: A method of controlling a level of a target protein in an insect cell, the method comprising contacting the insect cell with an effective amount of the compound of any one of embodiments 1-23, or with an effective amount of the composition of embodiment 24.

Embodiment 26: An embodiment of embodiment 25, wherein the controlling of the level of the target protein comprises degrading the target protein.

Embodiment 27: An embodiment of embodiment 25 or 26, wherein the insect cell is a cell of an insect, and wherein the contacting of the insect cell with an effective amount of the compound or composition comprises applying the compound or composition to an environment in which the insect is present.

Embodiment 28: An embodiment of embodiment 27, wherein the compound or composition is applied to an insect pest, a plant, a seed, the soil, or other surface in the environment in which the insect is present

### EXAMPLES

The present disclosure will be better understood in view of the following non-limiting examples. The following examples are intended for illustrative purposes only and do not limit in any way the scope of the embodiments.

Table 1 comprises bifunctional compounds having VHL ligase targeting moieties and FKBP protein targeting moieties. The compounds set forth in Table 1 were synthesized as described in detail below in Examples A1-A44.

TABLE 1

| Ex- | |
|---|---|
| ample | Structure |
| A-1 | 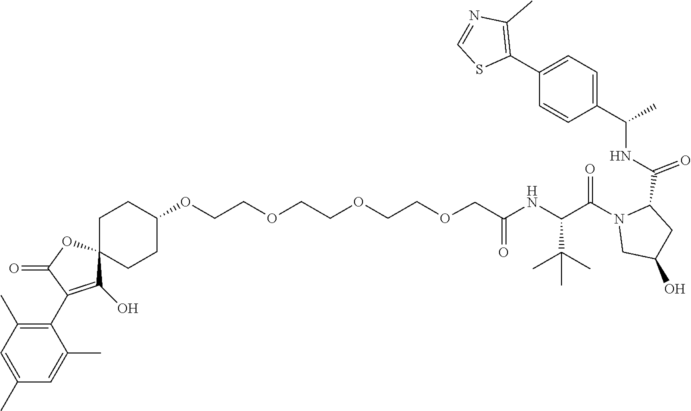 [SMILES: Cc1cc(C)c(C2=C(O)[C@]3(CC[C@H](OCCOCCOCCOCC(=O)N[C@H](C(=O)N4C[C@H](O)C[C@H]4C(=O)N[C@@H](C)c4ccc(-c5scnc5C)cc4)C(C)(C)C)CC3)OC2=O)c(C)c1] |
| A-2 | 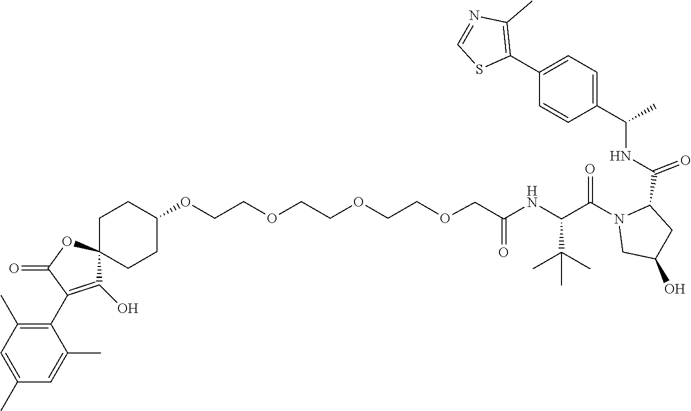 [SMILES: Cc1cc(C)c(C2=C(O)[C@]3(CC[C@@H](OCCOCCOCCOCC(=O)N[C@H](C(=O)N4C[C@H](O)C[C@H]4C(=O)N[C@@H](C)c4ccc(-c5scnc5C)cc4)C(C)(C)C)CC3)OC2=O)c(C)c1] |
| A-3 | 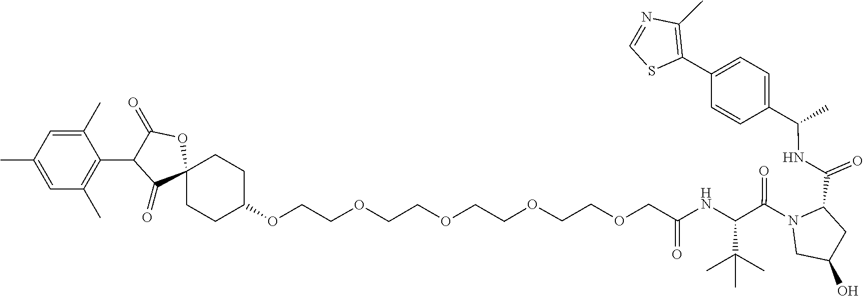 |
| A-4 | 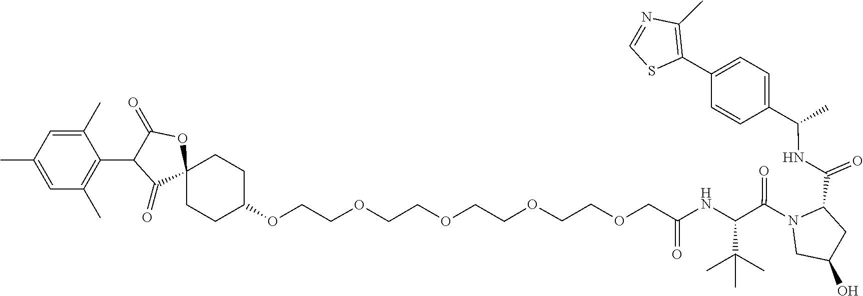 |
| A-5 | 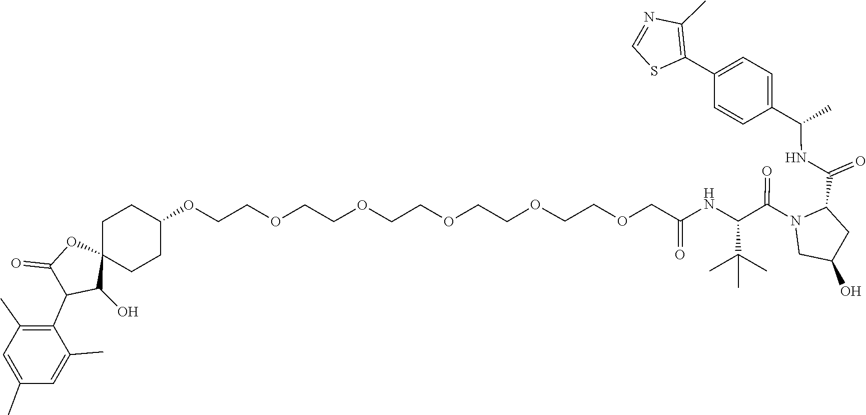 |
| A-6 | 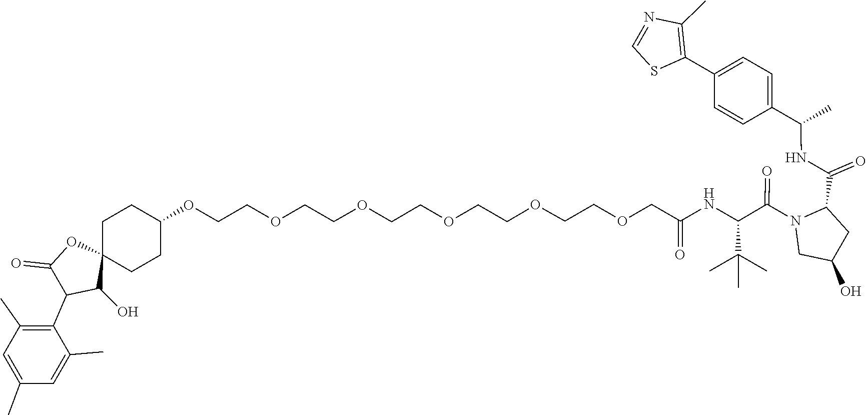 |
| A-7 | 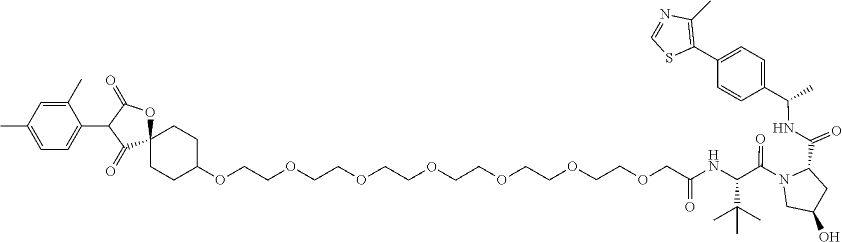 |
| A-8 | 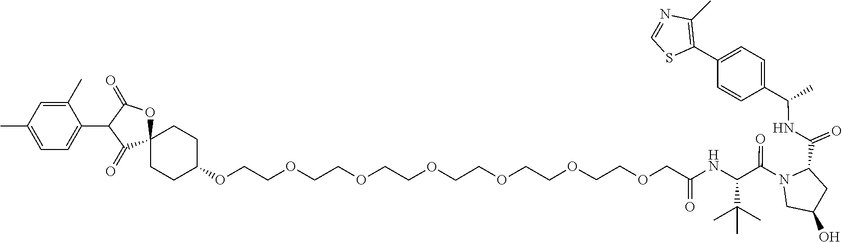 |
| A-9 | 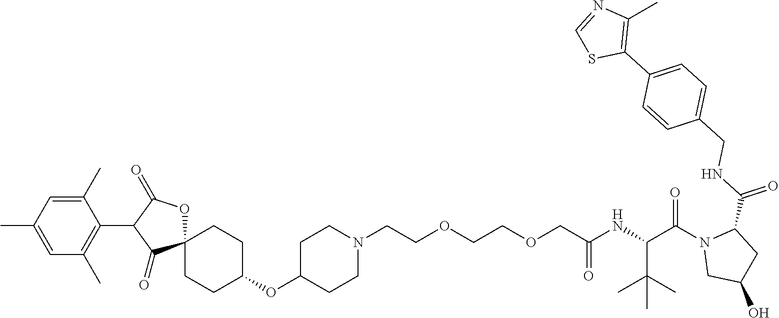 |
| A-10 | 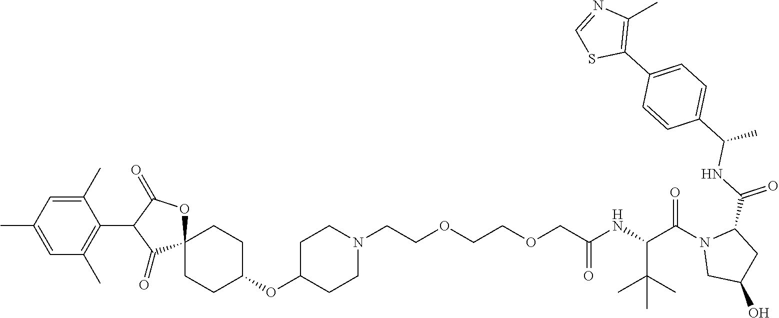 |
| A-11 | 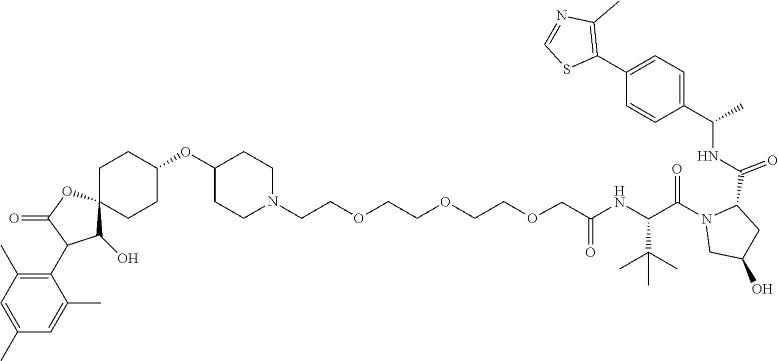 |
| A-12 | 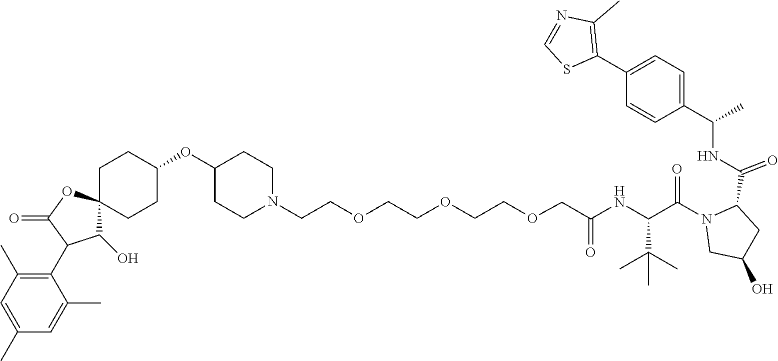 |
| A-13 | 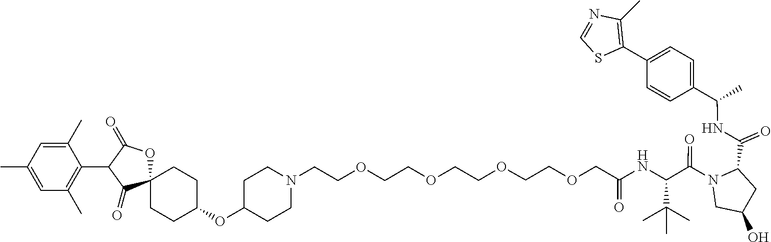 |
| A-14 | 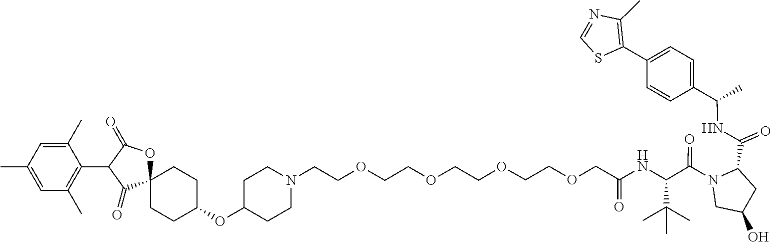 |
| A-15 | 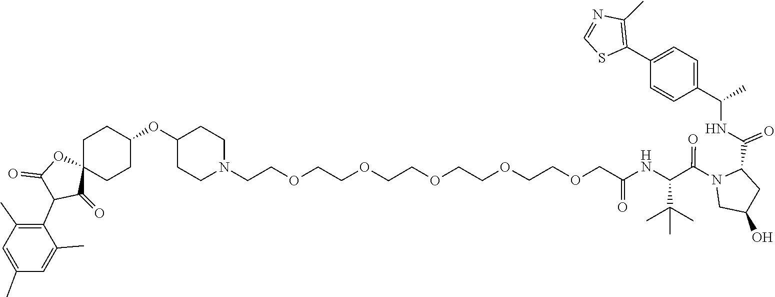 |
| A-16 | 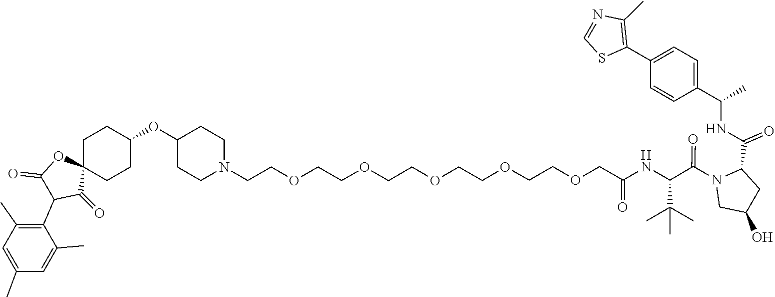 |
| A-17 | 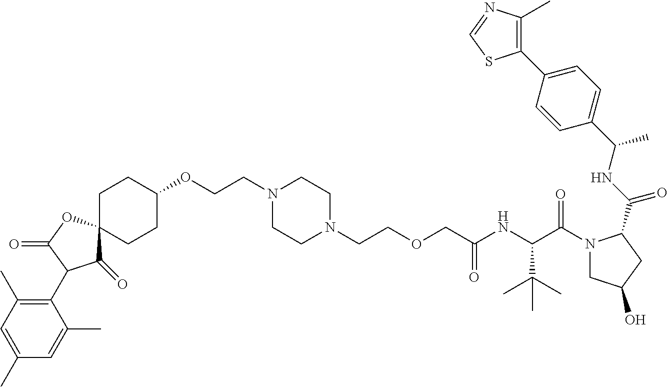 |
| A-18 | 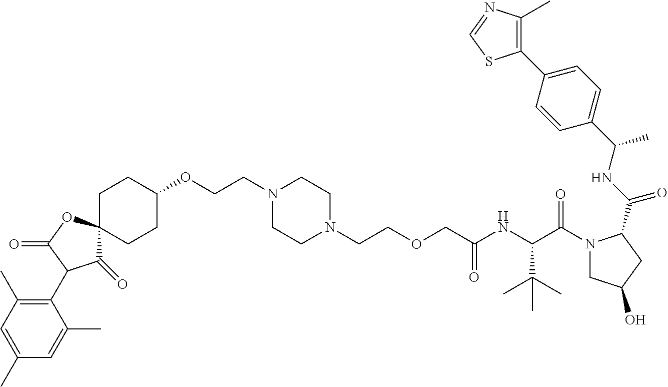 |
| A-19 | 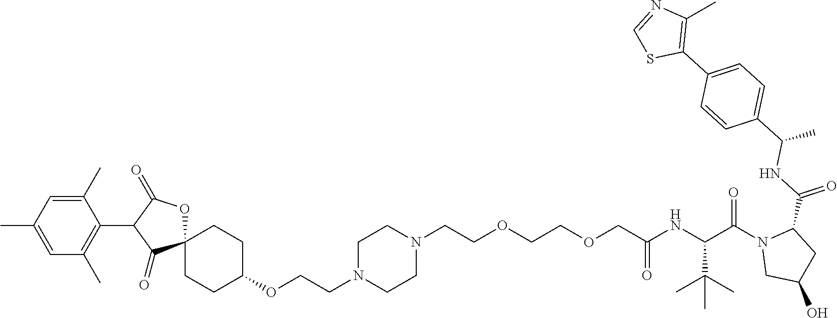 |
| A-20 | 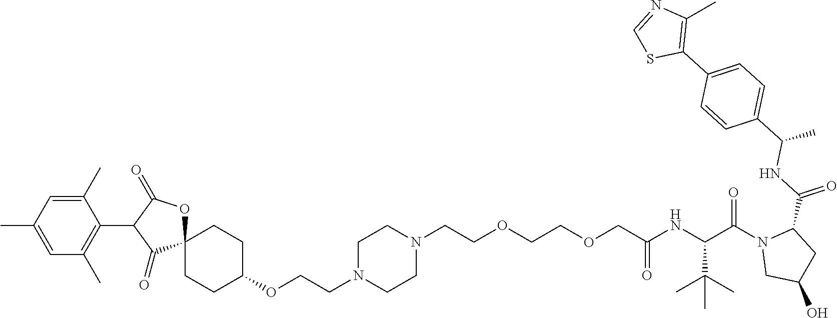 |
| A-21 | 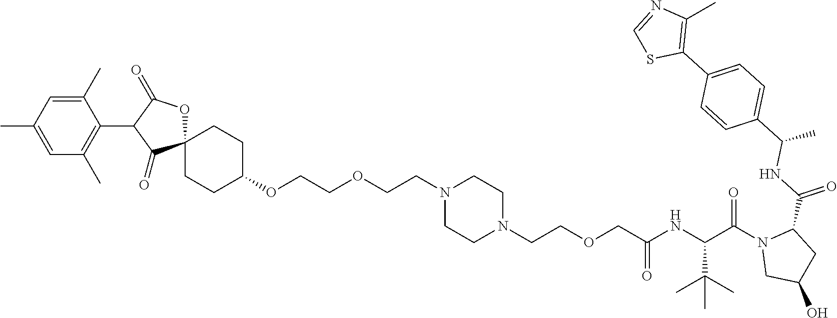 |
| A-22 | 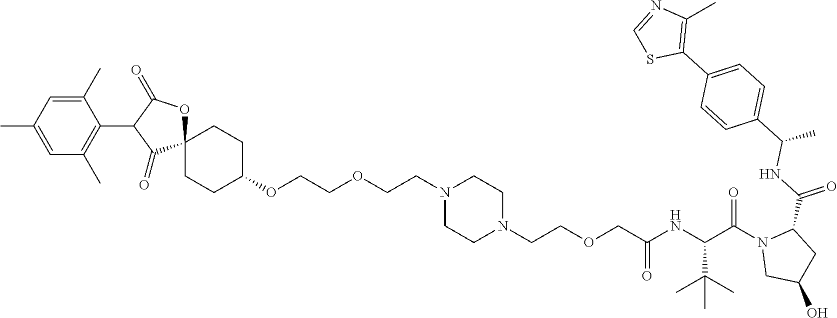 |
| A-23 | 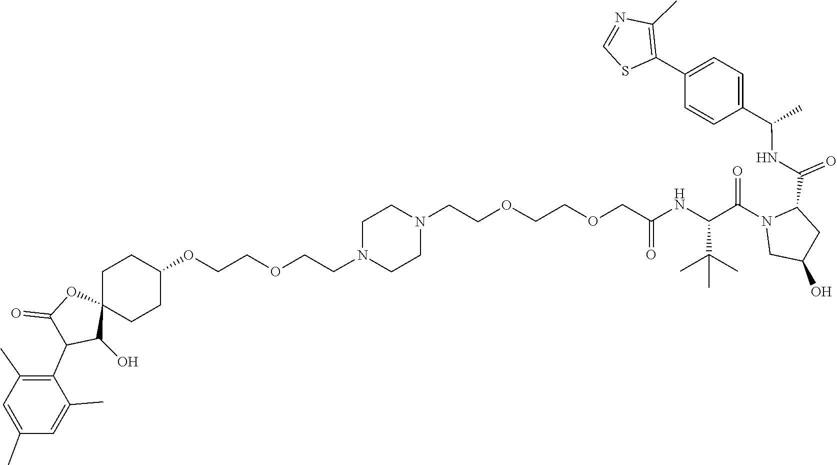 |
| A-24 | 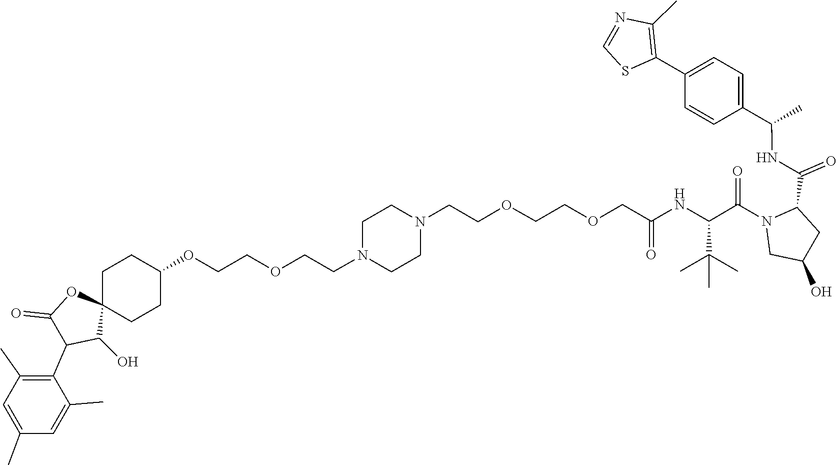 |
| A-25 | 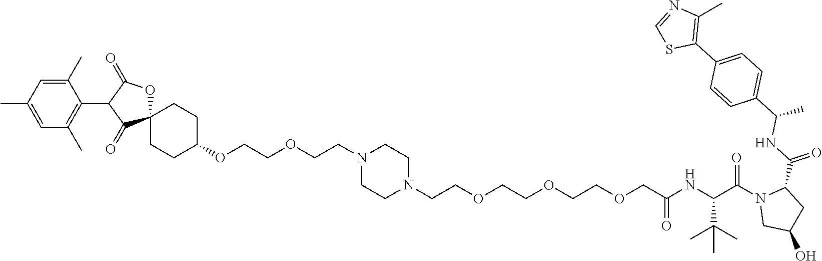 |
| A-26 | 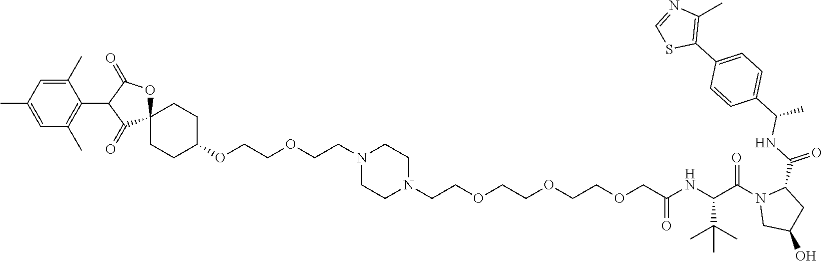 |
| A-27 | 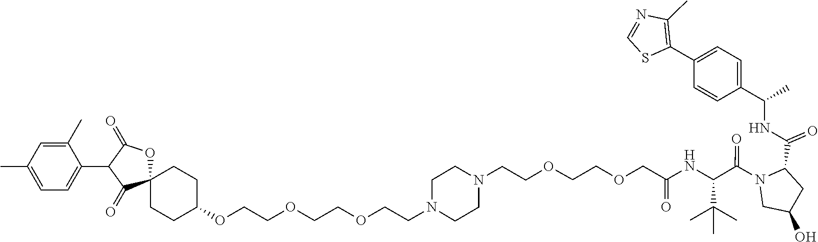 |
| A-28 | 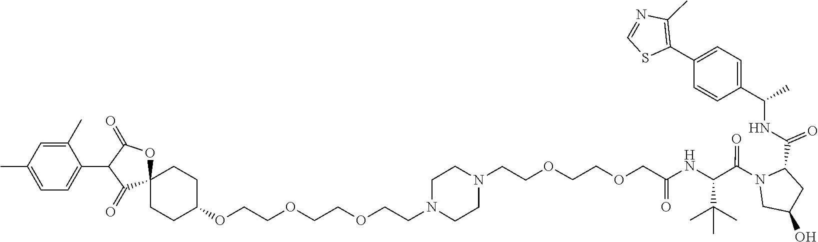 |
| A-31 | 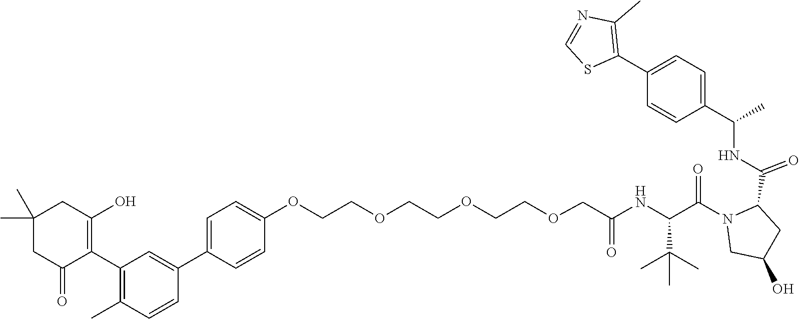 [SMILES: Cc1ccc(-c2ccc(OCCOCCOCCOCC(=O)N[C@H](C(=O)N3C[C@H](O)C[C@H]3C(=O)N[C@@H](C)c3ccc(-c4scnc4C)cc3)C(C)(C)C)cc2)cc1C1=C(O)CC(C)(C)CC1=O] |
| A-32 | 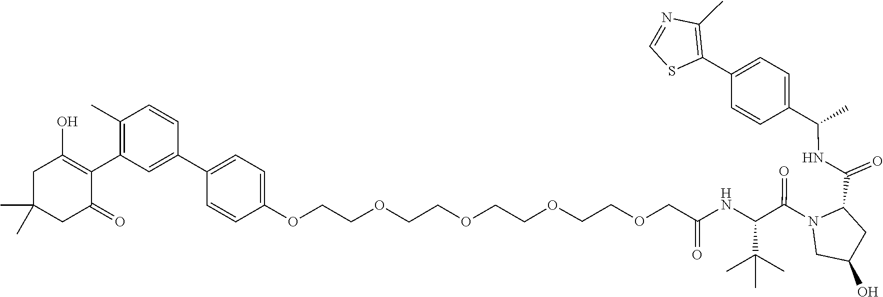 [SMILES: Cc1ccc(-c2ccc(OCCOCCOCCOCCOCC(=O)N[C@H](C(=O)N3C[C@H](O)C[C@H]3C(=O)N[C@@H](C)c3ccc(-c4scnc4C)cc3)C(C)(C)C)cc2)cc1C1=C(O)CC(C)(C)CC1=O] |
| A-33 | 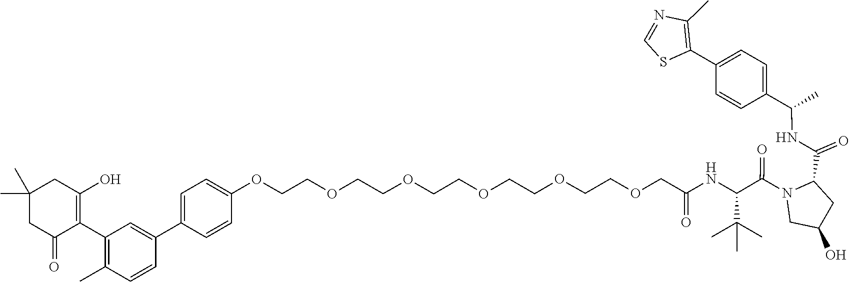 [SMILES: Cc1ccc(-c2ccc(OCCOCCOCCOCCOCCOCC(=O)N[C@H](C(=O)N3C[C@H](O)C[C@H]3C(=O)N[C@@H](C)c3ccc(-c4scnc4C)cc3)C(C)(C)C)cc2)cc1C1=C(O)CC(C)(C)CC1=O] |
| A-34 | 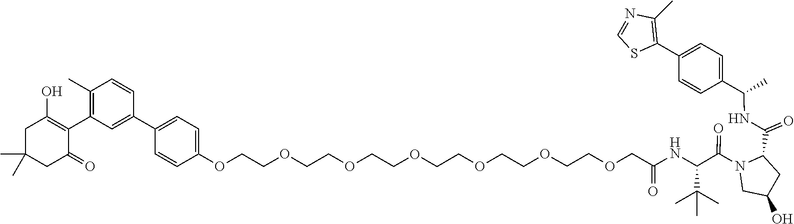 [SMILES: Cc1ccc(-c2ccc(OCCOCCOCCOCCOCCOCCOCC(=O)N[C@H](C(=O)N3C[C@H](O)C[C@H]3C(=O)N[C@@H](C)c3ccc(-c4scnc4C)cc3)C(C)(C)C)cc2)cc1C1=C(O)CC(C)(C)CC1=O] |
| A-35 | 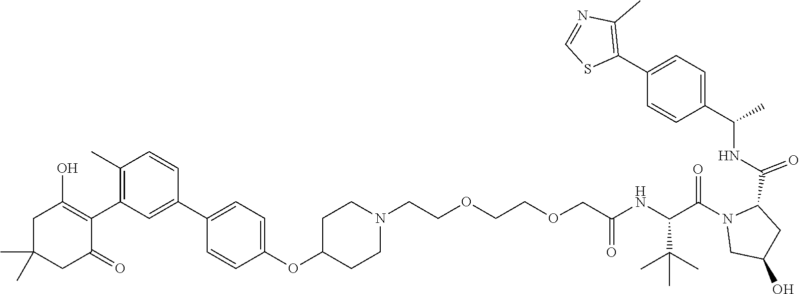 [SMILES: Cc1ccc(-c2ccc(OC3CCN(CCOCCOCC(=O)N[C@H](C(=O)N4C[C@H](O)C[C@H]4C(=O)N[C@@H](C)c4ccc(-c5scnc5C)cc4)C(C)(C)C)CC3)cc2)cc1C1=C(O)CC(C)(C)CC1=O] |
| A-36 | 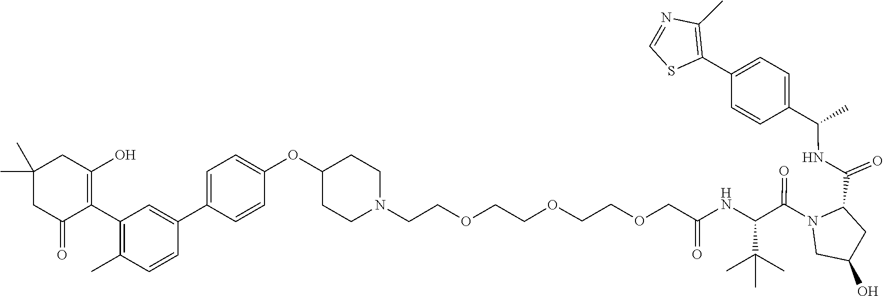 [SMILES: Cc1ccc(-c2ccc(OC3CCN(CCOCCOCCOCC(=O)N[C@H](C(=O)N4C[C@H](O)C[C@H]4C(=O)N[C@@H](C)c4ccc(-c5scnc5C)cc4)C(C)(C)C)CC3)cc2)cc1C1=C(O)CC(C)(C)CC1=O] |
| A-37 | 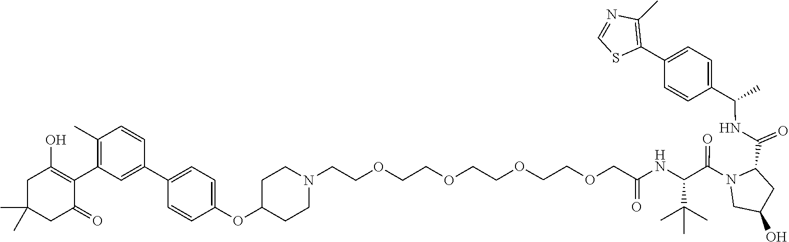 [SMILES: Cc1ccc(-c2ccc(OC3CCN(CCOCCOCCOCCOCC(=O)N[C@H](C(=O)N4C[C@H](O)C[C@H]4C(=O)N[C@@H](C)c4ccc(-c5scnc5C)cc4)C(C)(C)C)CC3)cc2)cc1C1=C(O)CC(C)(C)CC1=O] |
| A-38 | 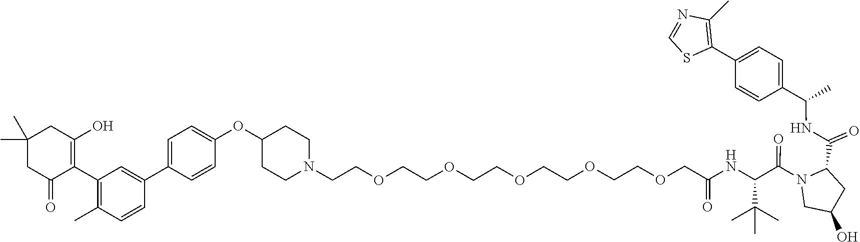 [SMILES: Cc1ccc(-c2ccc(OC3CCN(CCOCCOCCOCCOCCOCC(=O)N[C@H](C(=O)N4C[C@H](O)C[C@H]4C(=O)N[C@@H](C)c4ccc(-c5scnc5C)cc4)C(C)(C)C)CC3)cc2)cc1C1=C(O)CC(C)(C)CC1=O] |
| A-39 | 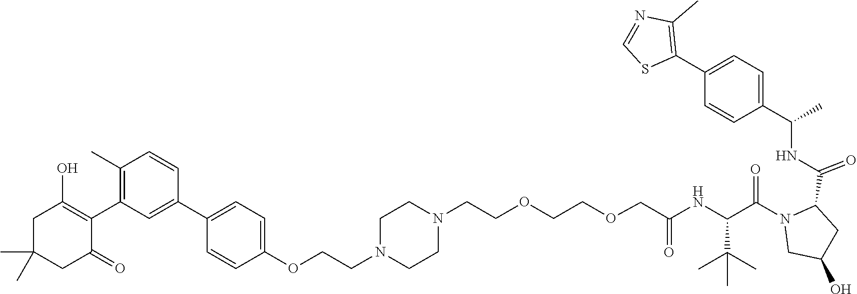 [SMILES: Cc1ccc(-c2ccc(OCCN3CCN(CCOCCOCC(=O)N[C@H](C(=O)N4C[C@H](O)C[C@H]4C(=O)N[C@@H](C)c4ccc(-c5scnc5C)cc4)C(C)(C)C)CC3)cc2)cc1C1=C(O)CC(C)(C)CC1=O] |
| A-40 | 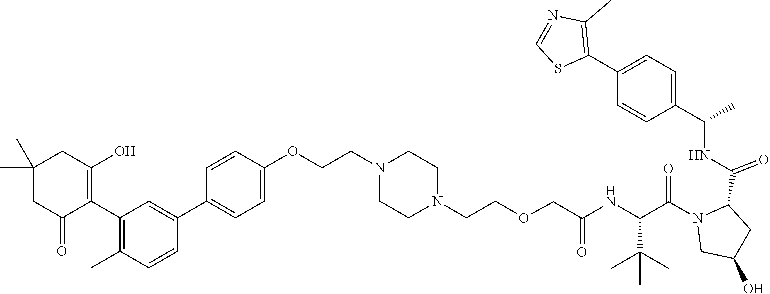 [SMILES: Cc1ccc(-c2ccc(OCCN3CCN(CCOCC(=O)N[C@H](C(=O)N4C[C@H](O)C[C@H]4C(=O)N[C@@H](C)c4ccc(-c5scnc5C)cc4)C(C)(C)C)CC3)cc2)cc1C1=C(O)CC(C)(C)CC1=O] |
| A-41 | 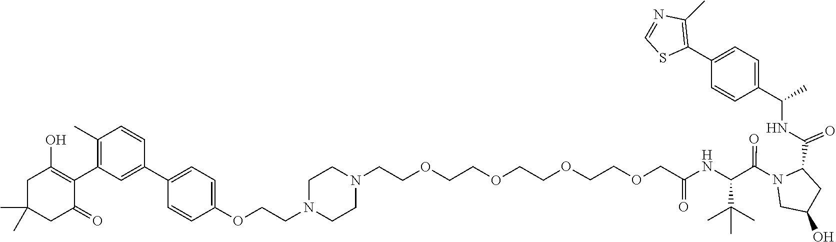 [SMILES: Cc1ccc(-c2ccc(OCCN3CCN(CCOCCOCCOCCOCC(=O)N[C@H](C(=O)N4C[C@H](O)C[C@H]4C(=O)N[C@@H](C)c4ccc(-c5scnc5C)cc4)C(C)(C)C)CC3)cc2)cc1C1=C(O)CC(C)(C)CC1=O] |
| A-42 | 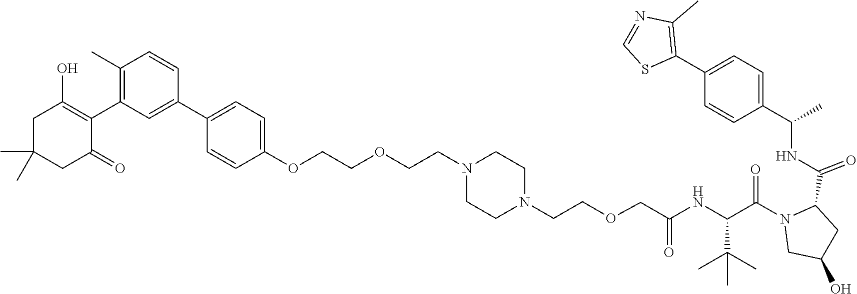 [SMILES: Cc1ccc(-c2ccc(OCCOCCN3CCN(CCOCC(=O)N[C@H](C(=O)N4C[C@H](O)C[C@H]4C(=O)N[C@@H](C)c4ccc(-c5scnc5C)cc4)C(C)(C)C)CC3)cc2)cc1C1=C(O)CC(C)(C)CC1=O] |
| A-43 | 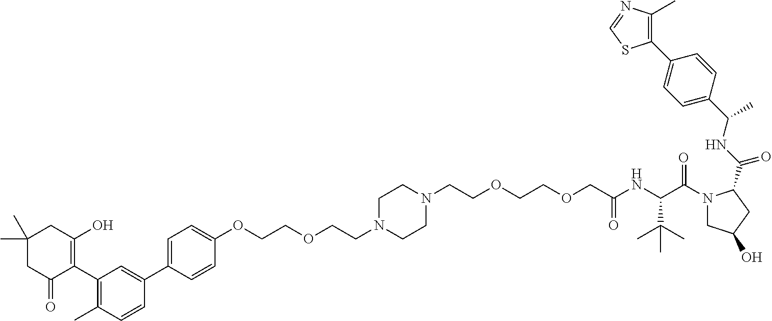 [SMILES: Cc1ccc(-c2ccc(OCCOCCN3CCN(CCOCCOCC(=O)N[C@H](C(=O)N4C[C@H](O)C[C@H]4C(=O)N[C@@H](C)c4ccc(-c5scnc5C)cc4)C(C)(C)C)CC3)cc2)cc1C1=C(O)CC(C)(C)CC1=O] |
| A-44 | 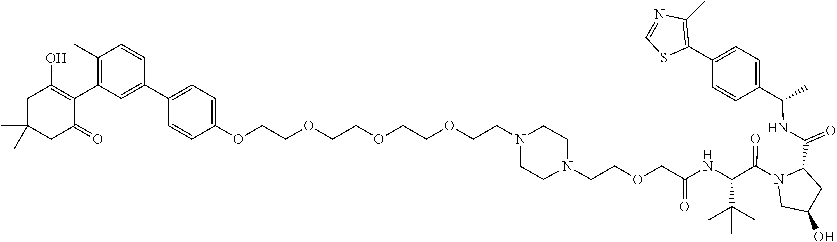 [SMILES: Cc1ccc(-c2ccc(OCCOCCOCCOCCN3CCN(CCOCC(=O)N[C@H](C(=O)N4C[C@H](O)C[C@H]4C(=O)N[C@@H](C)c4ccc(-c5scnc5C)cc4)C(C)(C)C)CC3)cc2)cc1C1=C(O)CC(C)(C)CC1=O] |

Table 2 comprises bifunctional compounds having VEL ligase targeting moieties and WDS protein targeting moieties. The compounds set forth in Table 2 were synthesized as described in detail below in Examples B1-B90.

TABLE 2

| Example | Structure |
|---|---|
| B-1 | 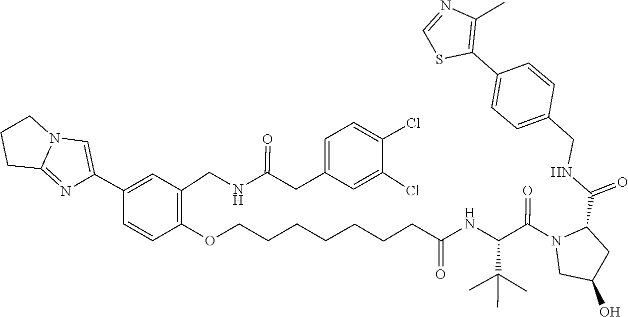 [SMILES: Cc1ncsc1-c1ccc(CNC(=O)[C@@H]2C[C@@H](O)CN2C(=O)[C@@H](NC(=O)CCCCCCCOc2ccc(-c3cn4c(n3)CCC4)cc2CNC(=O)Cc2ccc(Cl)c(Cl)c2)C(C)(C)C)cc1] |
| B-2 | 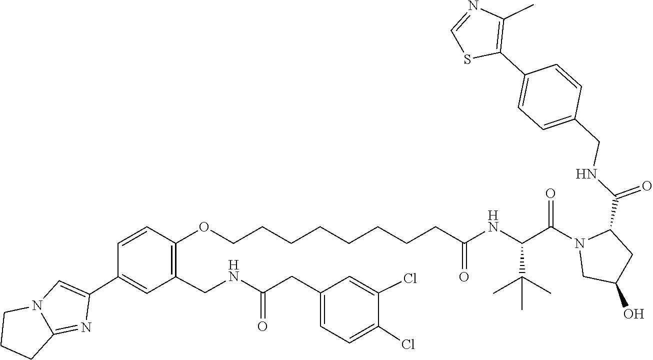 [SMILES: Cc1ncsc1-c1ccc(CNC(=O)[C@@H]2C[C@@H](O)CN2C(=O)[C@@H](NC(=O)CCCCCCCCOc2ccc(-c3cn4c(n3)CCC4)cc2CNC(=O)Cc2ccc(Cl)c(Cl)c2)C(C)(C)C)cc1] |
| B-3 | 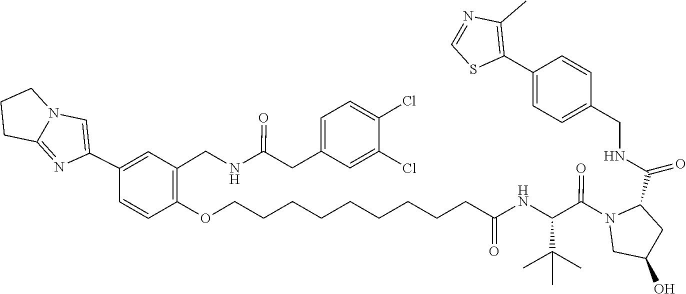 [SMILES: Cc1ncsc1-c1ccc(CNC(=O)[C@@H]2C[C@@H](O)CN2C(=O)[C@@H](NC(=O)CCCCCCCCCOc2ccc(-c3cn4c(n3)CCC4)cc2CNC(=O)Cc2ccc(Cl)c(Cl)c2)C(C)(C)C)cc1] |
| B-4 | 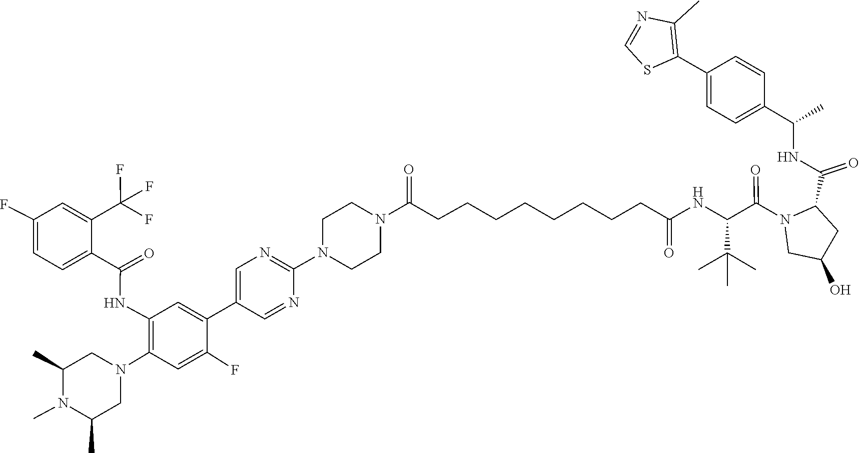 [SMILES: Cc1ncsc1-c1ccc([C@H](C)NC(=O)[C@@H]2C[C@@H](O)CN2C(=O)[C@@H](NC(=O)CCCCCCCCC(=O)N2CCN(c3ncc(-c4cc(NC(=O)c5ccc(F)cc5C(F)(F)F)c(N5C[C@@H](C)N(C)[C@@H](C)C5)cc4F)cn3)CC2)C(C)(C)C)cc1] |
| B-5 | 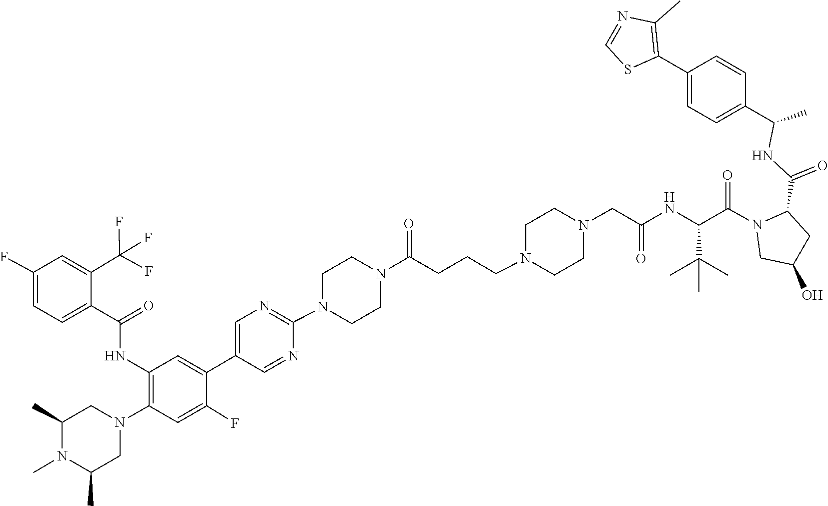 [SMILES: Cc1ncsc1-c1ccc([C@H](C)NC(=O)[C@@H]2C[C@@H](O)CN2C(=O)[C@@H](NC(=O)CN2CCN(CCCC(=O)N3CCN(c4ncc(-c5cc(NC(=O)c6ccc(F)cc6C(F)(F)F)c(N6C[C@@H](C)N(C)[C@@H](C)C6)cc5F)cn4)CC3)CC2)C(C)(C)C)cc1] |
| B-6 | 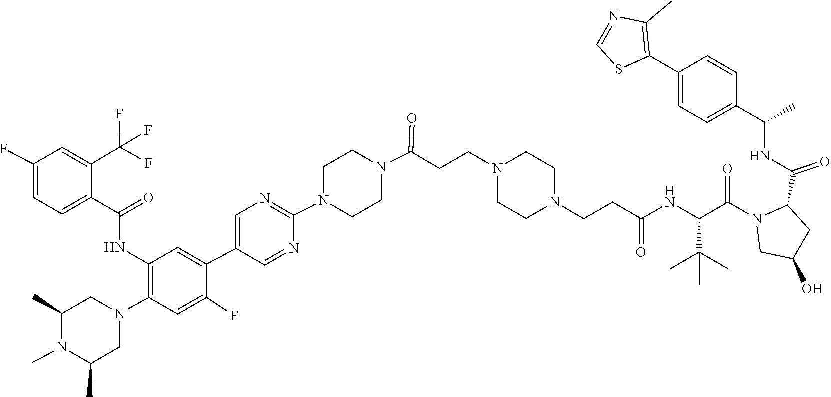 [SMILES: Cc1ncsc1-c1ccc([C@H](C)NC(=O)[C@@H]2C[C@@H](O)CN2C(=O)[C@@H](NC(=O)CCN2CCN(CCC(=O)N3CCN(c4ncc(-c5cc(NC(=O)c6ccc(F)cc6C(F)(F)F)c(N6C[C@@H](C)N(C)[C@@H](C)C6)cc5F)cn4)CC3)CC2)C(C)(C)C)cc1] |
| B-7 | 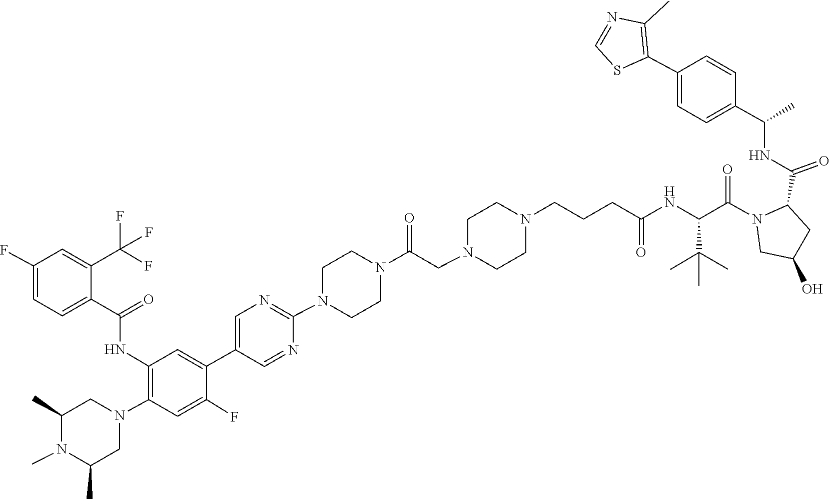 [SMILES: Cc1ncsc1-c1ccc([C@H](C)NC(=O)[C@@H]2C[C@@H](O)CN2C(=O)[C@@H](NC(=O)CCCN2CCN(CC(=O)N3CCN(c4ncc(-c5cc(NC(=O)c6ccc(F)cc6C(F)(F)F)c(N6C[C@@H](C)N(C)[C@@H](C)C6)cc5F)cn4)CC3)CC2)C(C)(C)C)cc1] |
| B-8 | 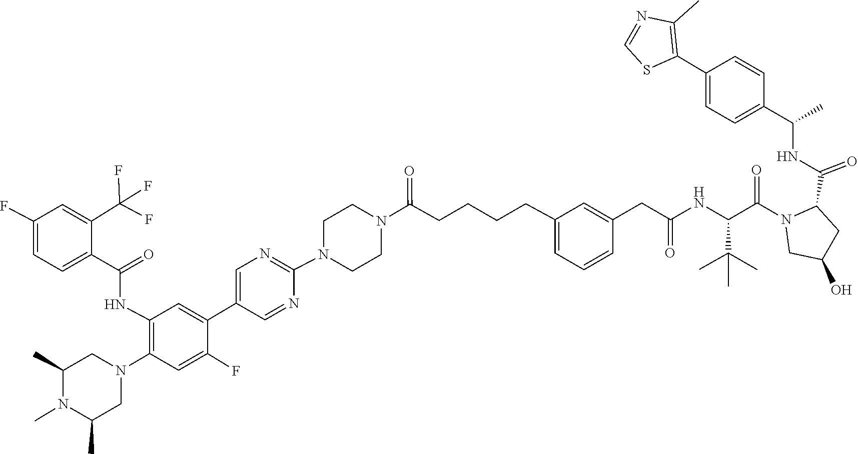 [SMILES: Cc1ncsc1-c1ccc([C@H](C)NC(=O)[C@@H]2C[C@@H](O)CN2C(=O)[C@@H](NC(=O)Cc2cccc(CCCCC(=O)N3CCN(c4ncc(-c5cc(NC(=O)c6ccc(F)cc6C(F)(F)F)c(N6C[C@@H](C)N(C)[C@@H](C)C6)cc5F)cn4)CC3)c2)C(C)(C)C)cc1] |
| B-9 | 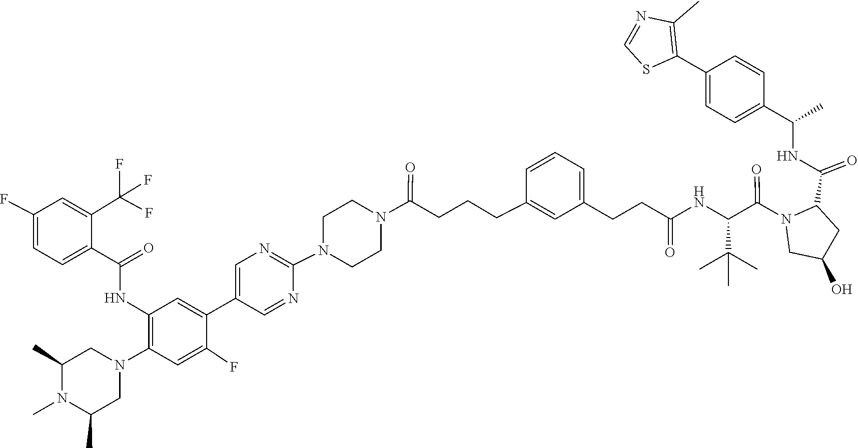 |
| B-10 | 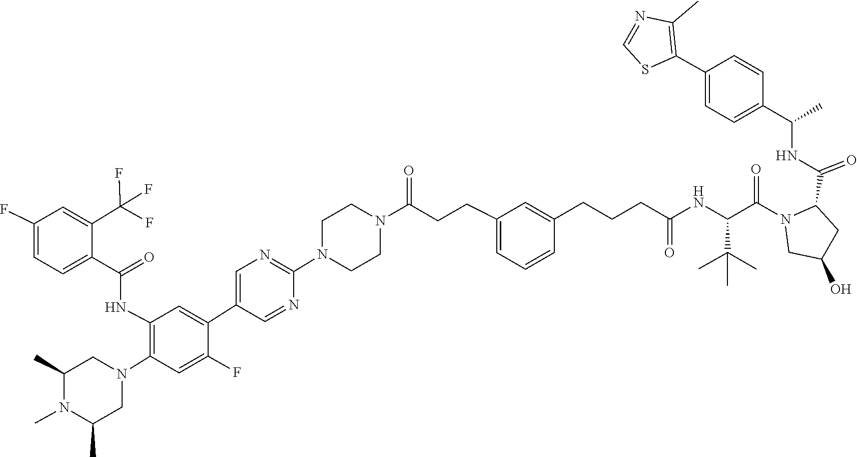 [SMILES: Cc1ncsc1-c1ccc([C@H](C)NC(=O)[C@@H]2C[C@@H](O)CN2C(=O)[C@@H](NC(=O)CCCc2cccc(CCC(=O)N3CCN(c4ncc(-c5cc(NC(=O)c6ccc(F)cc6C(F)(F)F)c(N6C[C@@H](C)N(C)[C@@H](C)C6)cc5F)cn4)CC3)c2)C(C)(C)C)cc1] |
| B-11 | 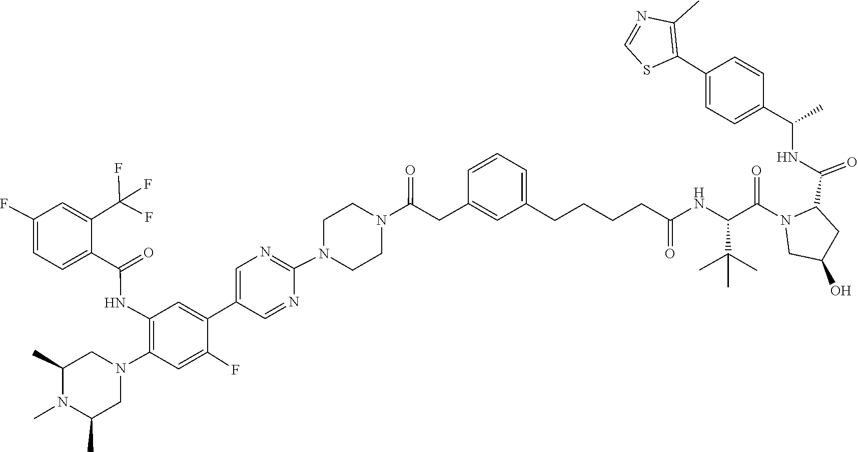 |
| B-12 | 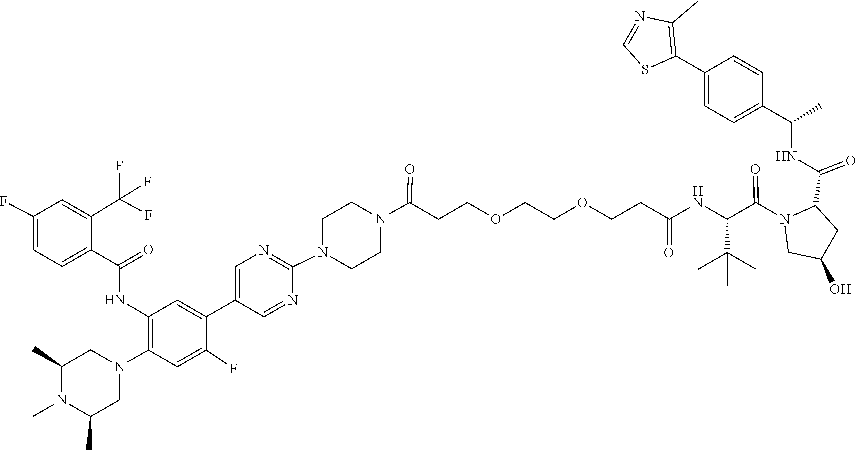 |
| B-13 | 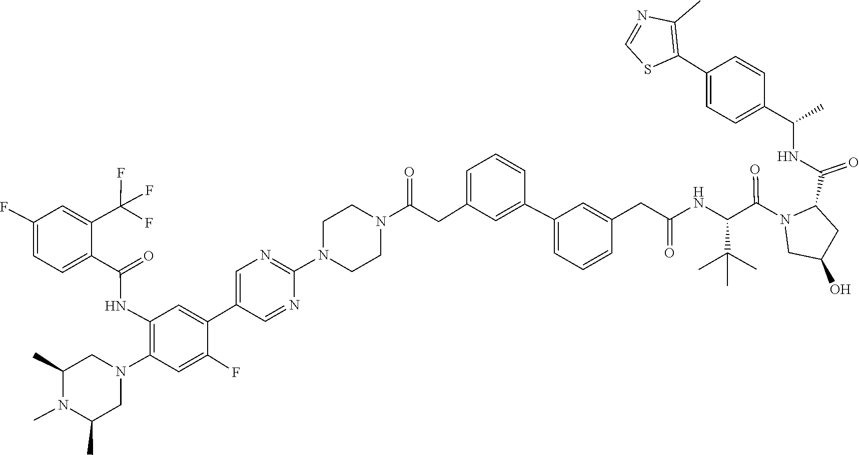 [SMILES: Cc1ncsc1-c1ccc([C@H](C)NC(=O)[C@@H]2C[C@@H](O)CN2C(=O)[C@@H](NC(=O)Cc2cccc(-c3cccc(CC(=O)N4CCN(c5ncc(-c6cc(NC(=O)c7ccc(F)cc7C(F)(F)F)c(N7C[C@@H](C)N(C)[C@@H](C)C7)cc6F)cn5)CC4)c3)c2)C(C)(C)C)cc1] |
| B-14 | 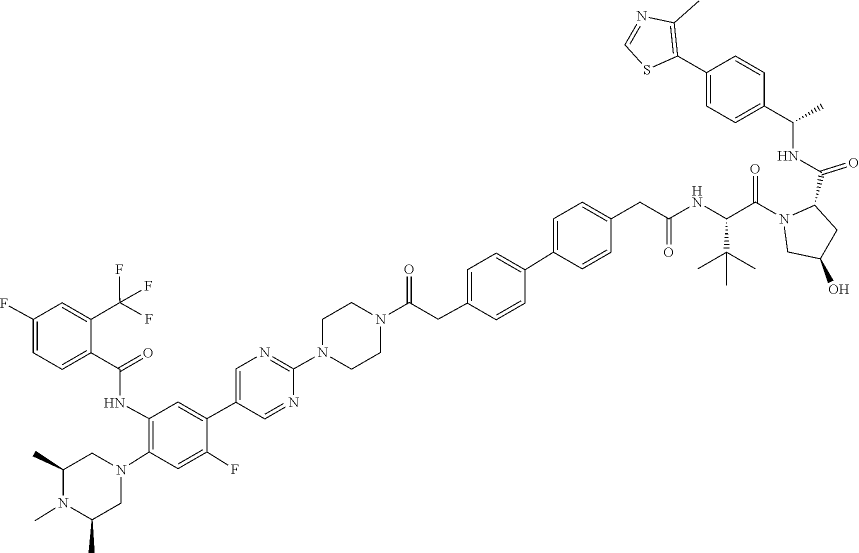 [SMILES: Cc1ncsc1-c1ccc([C@H](C)NC(=O)[C@@H]2C[C@@H](O)CN2C(=O)[C@@H](NC(=O)Cc2ccc(-c3ccc(CC(=O)N4CCN(c5ncc(-c6cc(NC(=O)c7ccc(F)cc7C(F)(F)F)c(N7C[C@@H](C)N(C)[C@@H](C)C7)cc6F)cn5)CC4)cc3)cc2)C(C)(C)C)cc1] |
| B-15 | 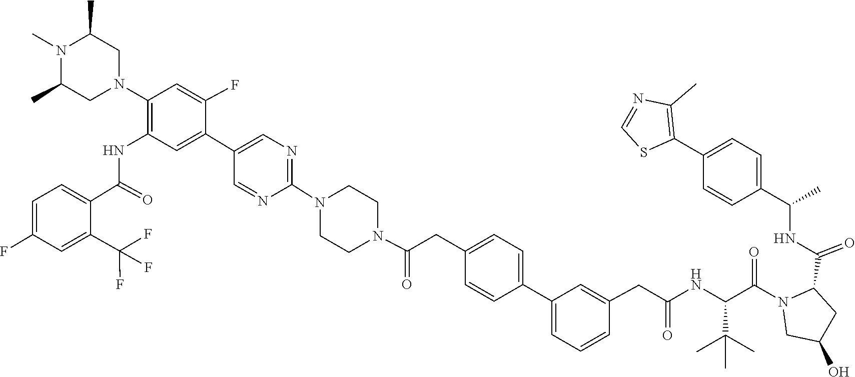 [SMILES: Cc1ncsc1-c1ccc([C@H](C)NC(=O)[C@@H]2C[C@@H](O)CN2C(=O)[C@@H](NC(=O)Cc2cccc(-c3ccc(CC(=O)N4CCN(c5ncc(-c6cc(NC(=O)c7ccc(F)cc7C(F)(F)F)c(N7C[C@@H](C)N(C)[C@@H](C)C7)cc6F)cn5)CC4)cc3)c2)C(C)(C)C)cc1] |
| B-16 | 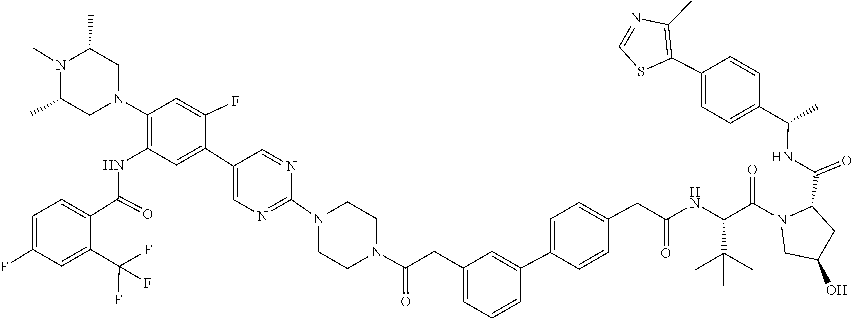 [SMILES: Cc1ncsc1-c1ccc([C@H](C)NC(=O)[C@@H]2C[C@@H](O)CN2C(=O)[C@@H](NC(=O)Cc2ccc(-c3cccc(CC(=O)N4CCN(c5ncc(-c6cc(NC(=O)c7ccc(F)cc7C(F)(F)F)c(N7C[C@@H](C)N(C)[C@@H](C)C7)cc6F)cn5)CC4)c3)cc2)C(C)(C)C)cc1] |
| B-17 | 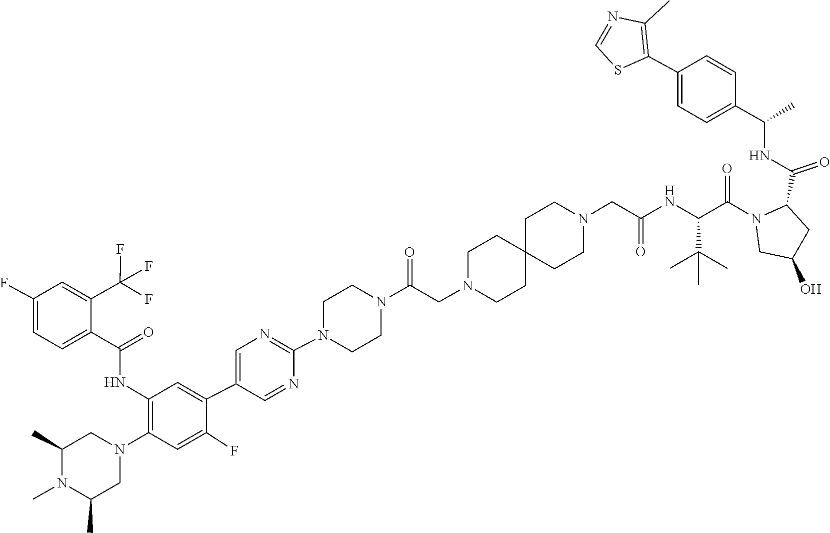 [SMILES: Cc1ncsc1-c1ccc([C@H](C)NC(=O)[C@@H]2C[C@@H](O)CN2C(=O)[C@@H](NC(=O)CN2CCC3(CC2)CCN(CC(=O)N2CCN(c4ncc(-c5cc(NC(=O)c6ccc(F)cc6C(F)(F)F)c(N6C[C@@H](C)N(C)[C@@H](C)C6)cc5F)cn4)CC2)CC3)C(C)(C)C)cc1] |
| B-18 | 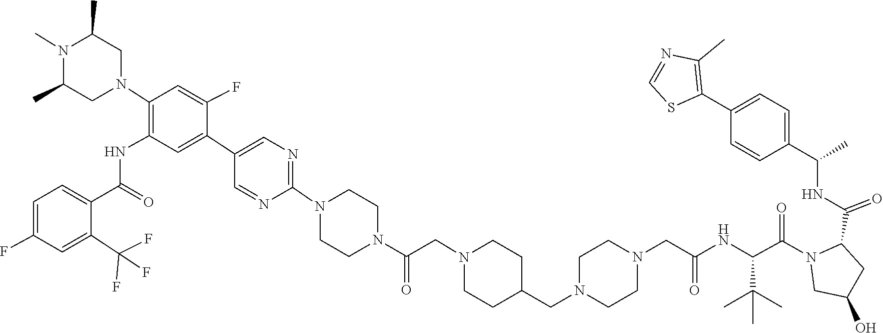 [SMILES: Cc1ncsc1-c1ccc([C@H](C)NC(=O)[C@@H]2C[C@@H](O)CN2C(=O)[C@@H](NC(=O)CN2CCN(CC3CCN(CC(=O)N4CCN(c5ncc(-c6cc(NC(=O)c7ccc(F)cc7C(F)(F)F)c(N7C[C@@H](C)N(C)[C@@H](C)C7)cc6F)cn5)CC4)CC3)CC2)C(C)(C)C)cc1] |
| B-19 | 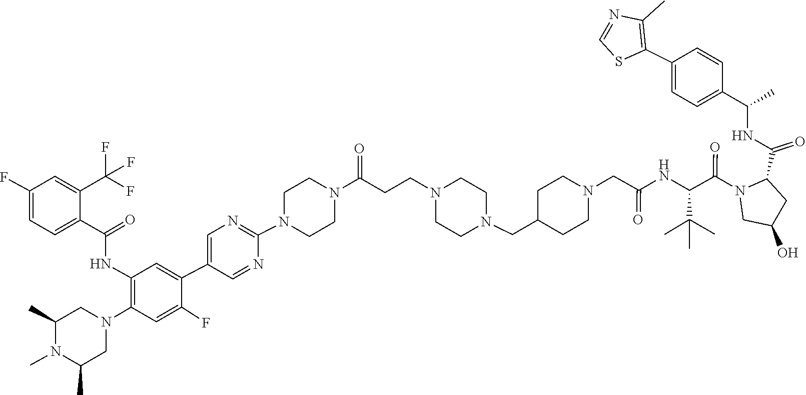 [SMILES: Cc1ncsc1-c1ccc([C@H](C)NC(=O)[C@@H]2C[C@@H](O)CN2C(=O)[C@@H](NC(=O)CN2CCC(CN3CCN(CCC(=O)N4CCN(c5ncc(-c6cc(NC(=O)c7ccc(F)cc7C(F)(F)F)c(N7C[C@@H](C)N(C)[C@@H](C)C7)cc6F)cn5)CC4)CC3)CC2)C(C)(C)C)cc1] |
| B-20 | 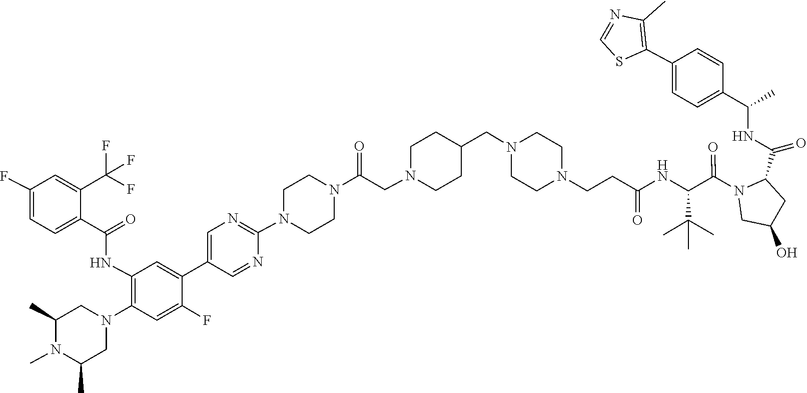 [SMILES: Cc1ncsc1-c1ccc([C@H](C)NC(=O)[C@@H]2C[C@@H](O)CN2C(=O)[C@@H](NC(=O)CCN2CCN(CC3CCN(CC(=O)N4CCN(c5ncc(-c6cc(NC(=O)c7ccc(F)cc7C(F)(F)F)c(N7C[C@@H](C)N(C)[C@@H](C)C7)cc6F)cn5)CC4)CC3)CC2)C(C)(C)C)cc1] |
| B-21 | 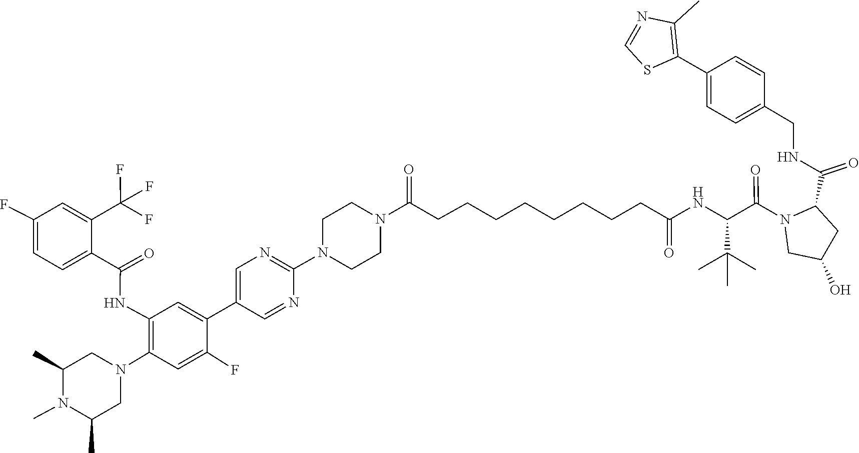 [SMILES: Cc1ncsc1-c1ccc(CNC(=O)[C@@H]2C[C@H](O)CN2C(=O)[C@@H](NC(=O)CCCCCCCCC(=O)N2CCN(c3ncc(-c4cc(NC(=O)c5ccc(F)cc5C(F)(F)F)c(N5C[C@@H](C)N(C)[C@@H](C)C5)cc4F)cn3)CC2)C(C)(C)C)cc1] |
| B-22 | 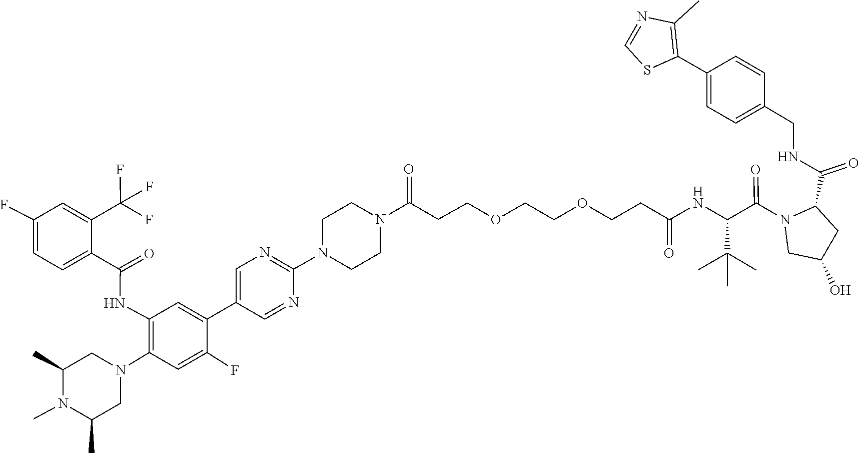 [SMILES: Cc1ncsc1-c1ccc(CNC(=O)[C@@H]2C[C@H](O)CN2C(=O)[C@@H](NC(=O)CCOCCOCCC(=O)N2CCN(c3ncc(-c4cc(NC(=O)c5ccc(F)cc5C(F)(F)F)c(N5C[C@@H](C)N(C)[C@@H](C)C5)cc4F)cn3)CC2)C(C)(C)C)cc1] |
| | 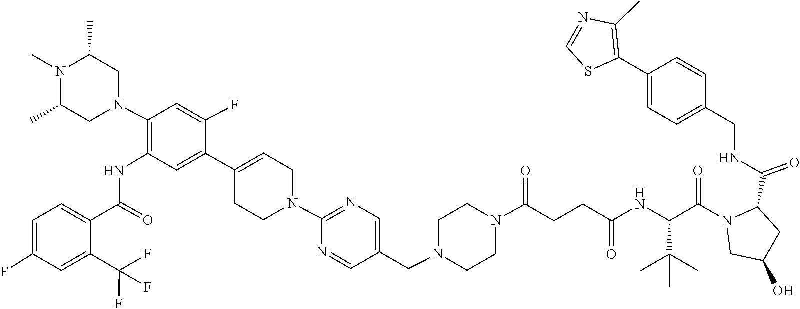 [SMILES: Cc1ncsc1-c1ccc(CNC(=O)[C@@H]2C[C@@H](O)CN2C(=O)[C@@H](NC(=O)CCC(=O)N2CCN(Cc3cnc(N4CC=C(c5cc(NC(=O)c6ccc(F)cc6C(F)(F)F)c(N6C[C@@H](C)N(C)[C@@H](C)C6)cc5F)CC4)nc3)CC2)C(C)(C)C)cc1] |
| B-24 | 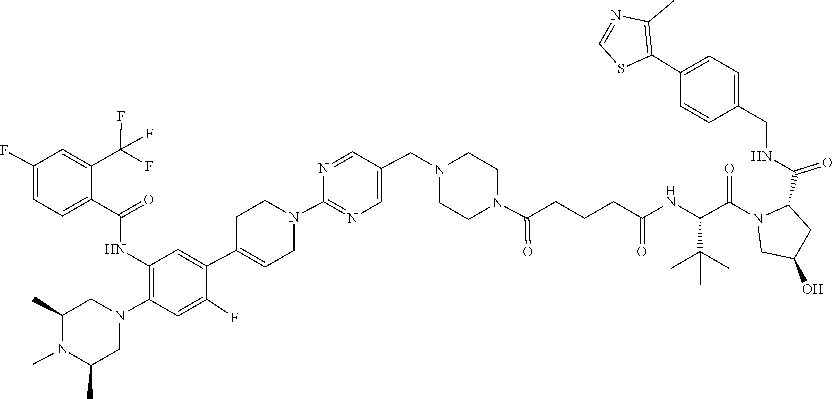 [SMILES: Cc1ncsc1-c1ccc(CNC(=O)[C@@H]2C[C@@H](O)CN2C(=O)[C@@H](NC(=O)CCCC(=O)N2CCN(Cc3cnc(N4CC=C(c5cc(NC(=O)c6ccc(F)cc6C(F)(F)F)c(N6C[C@@H](C)N(C)[C@@H](C)C6)cc5F)CC4)nc3)CC2)C(C)(C)C)cc1] |
| B-25 | 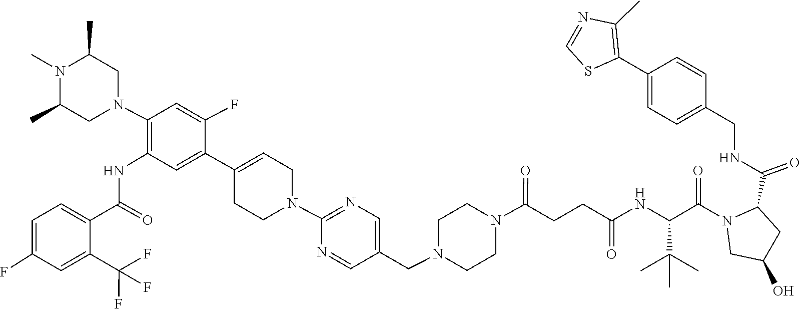 [SMILES: Cc1ncsc1-c1ccc(CNC(=O)[C@@H]2C[C@@H](O)CN2C(=O)[C@@H](NC(=O)CCC(=O)N2CCN(Cc3cnc(N4CC=C(c5cc(NC(=O)c6ccc(F)cc6C(F)(F)F)c(N6C[C@@H](C)N(C)[C@@H](C)C6)cc5F)CC4)nc3)CC2)C(C)(C)C)cc1] |
| B-26 | 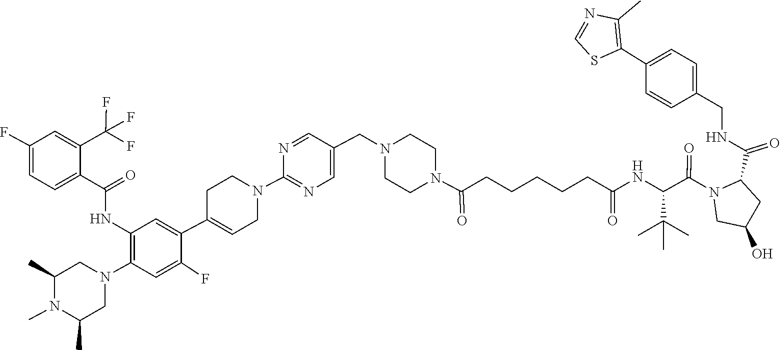 [SMILES: Cc1ncsc1-c1ccc(CNC(=O)[C@@H]2C[C@@H](O)CN2C(=O)[C@@H](NC(=O)CCCCCC(=O)N2CCN(Cc3cnc(N4CC=C(c5cc(NC(=O)c6ccc(F)cc6C(F)(F)F)c(N6C[C@@H](C)N(C)[C@@H](C)C6)cc5F)CC4)nc3)CC2)C(C)(C)C)cc1] |
| B-27 | 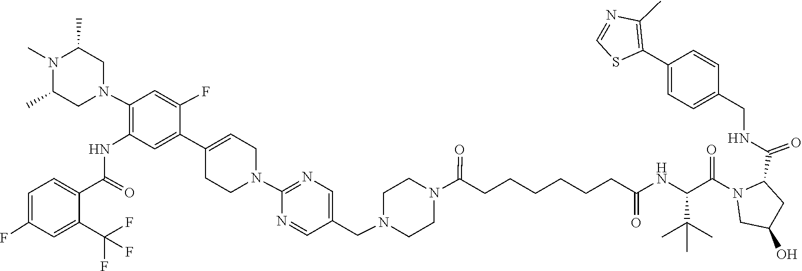 [SMILES: Cc1ncsc1-c1ccc(CNC(=O)[C@@H]2C[C@@H](O)CN2C(=O)[C@@H](NC(=O)CCCCCCC(=O)N2CCN(Cc3cnc(N4CC=C(c5cc(NC(=O)c6ccc(F)cc6C(F)(F)F)c(N6C[C@@H](C)N(C)[C@@H](C)C6)cc5F)CC4)nc3)CC2)C(C)(C)C)cc1] |
| B-28 | 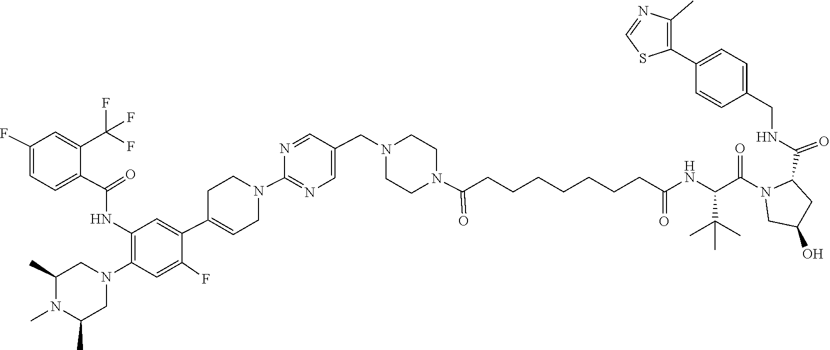 [SMILES: Cc1ncsc1-c1ccc(CNC(=O)[C@@H]2C[C@@H](O)CN2C(=O)[C@@H](NC(=O)CCCCCCCC(=O)N2CCN(Cc3cnc(N4CC=C(c5cc(NC(=O)c6ccc(F)cc6C(F)(F)F)c(N6C[C@@H](C)N(C)[C@@H](C)C6)cc5F)CC4)nc3)CC2)C(C)(C)C)cc1] |
| B-29 | 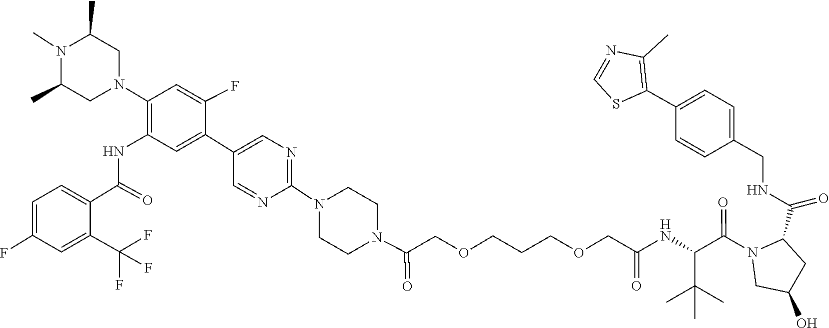 [SMILES: Cc1ncsc1-c1ccc(CNC(=O)[C@@H]2C[C@@H](O)CN2C(=O)[C@@H](NC(=O)COCCCOCC(=O)N2CCN(c3ncc(-c4cc(NC(=O)c5ccc(F)cc5C(F)(F)F)c(N5C[C@@H](C)N(C)[C@@H](C)C5)cc4F)cn3)CC2)C(C)(C)C)cc1] |
| B-30 | 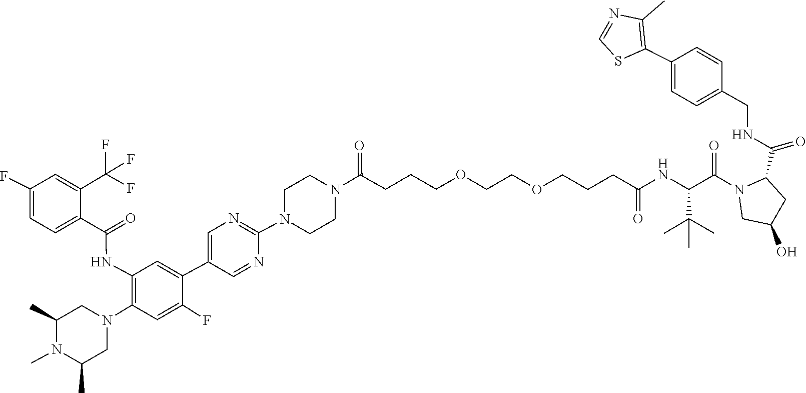 [SMILES: Cc1ncsc1-c1ccc(CNC(=O)[C@@H]2C[C@@H](O)CN2C(=O)[C@@H](NC(=O)CCCOCCOCCCC(=O)N2CCN(c3ncc(-c4cc(NC(=O)c5ccc(F)cc5C(F)(F)F)c(N5C[C@@H](C)N(C)[C@@H](C)C5)cc4F)cn3)CC2)C(C)(C)C)cc1] |
| B-31 | 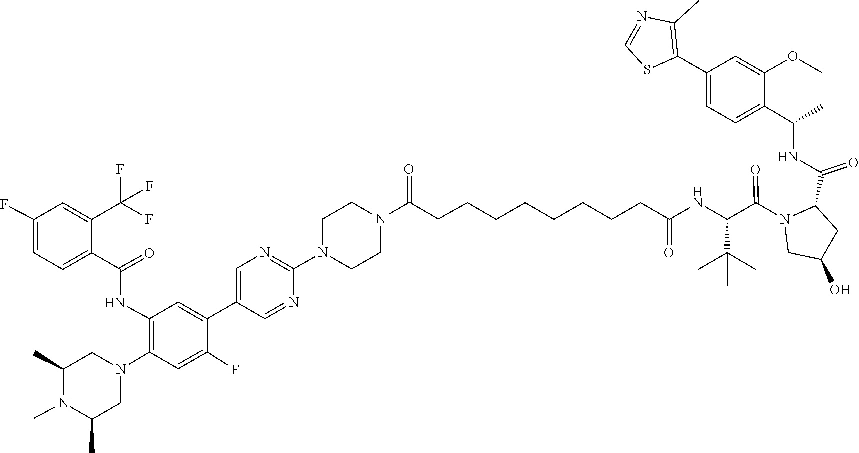 [SMILES: COc1cc(-c2scnc2C)ccc1[C@H](C)NC(=O)[C@@H]1C[C@@H](O)CN1C(=O)[C@@H](NC(=O)CCCCCCCCC(=O)N1CCN(c2ncc(-c3cc(NC(=O)c4ccc(F)cc4C(F)(F)F)c(N4C[C@@H](C)N(C)[C@@H](C)C4)cc3F)cn2)CC1)C(C)(C)C] |
| B-32 | 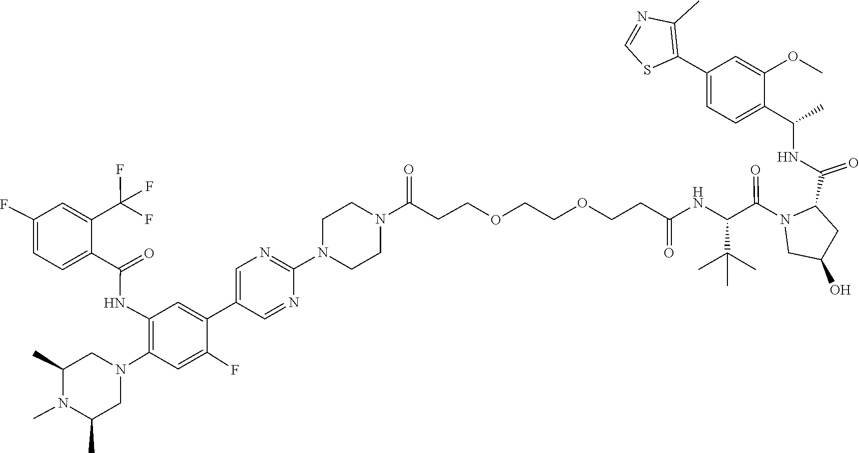 [SMILES: COc1cc(-c2scnc2C)ccc1[C@H](C)NC(=O)[C@@H]1C[C@@H](O)CN1C(=O)[C@@H](NC(=O)CCOCCOCCC(=O)N1CCN(c2ncc(-c3cc(NC(=O)c4ccc(F)cc4C(F)(F)F)c(N4C[C@@H](C)N(C)[C@@H](C)C4)cc3F)cn2)CC1)C(C)(C)C] |
| B-33 | 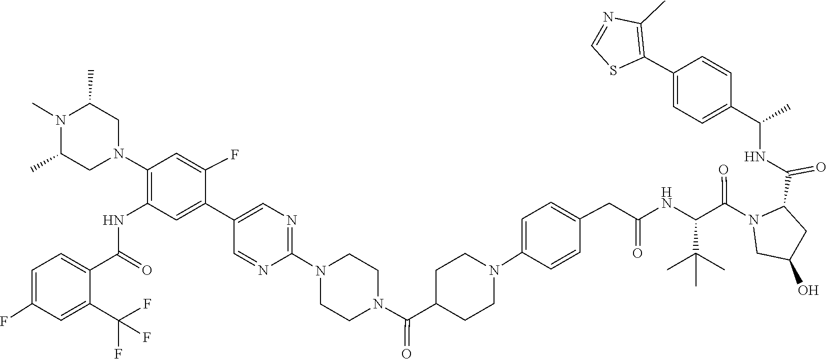 [SMILES: Cc1ncsc1-c1ccc([C@H](C)NC(=O)[C@@H]2C[C@@H](O)CN2C(=O)[C@@H](NC(=O)Cc2ccc(N3CCC(C(=O)N4CCN(c5ncc(-c6cc(NC(=O)c7ccc(F)cc7C(F)(F)F)c(N7C[C@@H](C)N(C)[C@@H](C)C7)cc6F)cn5)CC4)CC3)cc2)C(C)(C)C)cc1] |
| B-34 | 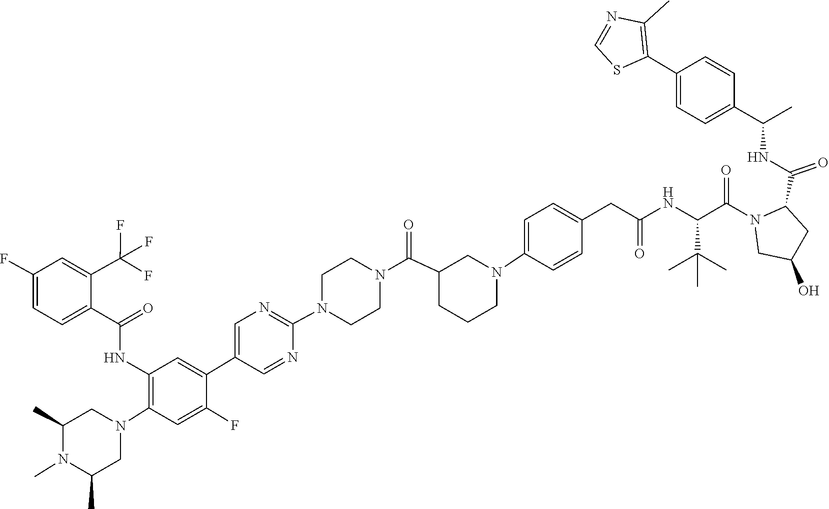 [SMILES: Cc1ncsc1-c1ccc([C@H](C)NC(=O)[C@@H]2C[C@@H](O)CN2C(=O)[C@@H](NC(=O)Cc2ccc(N3CCCC(C(=O)N4CCN(c5ncc(-c6cc(NC(=O)c7ccc(F)cc7C(F)(F)F)c(N7C[C@@H](C)N(C)[C@@H](C)C7)cc6F)cn5)CC4)C3)cc2)C(C)(C)C)cc1] |
| B-35 | 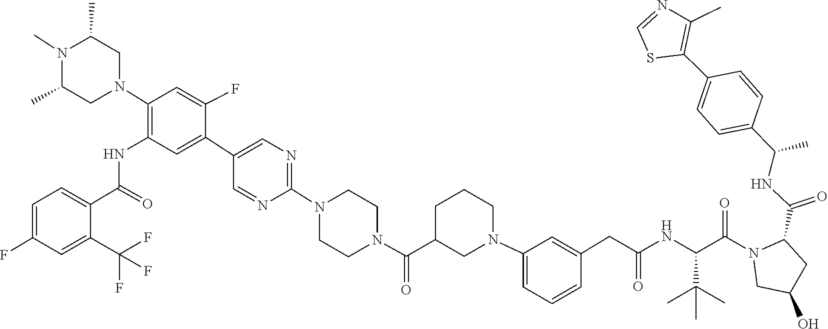 [SMILES: Cc1ncsc1-c1ccc([C@H](C)NC(=O)[C@@H]2C[C@@H](O)CN2C(=O)[C@@H](NC(=O)Cc2cccc(N3CCCC(C(=O)N4CCN(c5ncc(-c6cc(NC(=O)c7ccc(F)cc7C(F)(F)F)c(N7C[C@@H](C)N(C)[C@@H](C)C7)cc6F)cn5)CC4)C3)c2)C(C)(C)C)cc1] |
| B-36 | 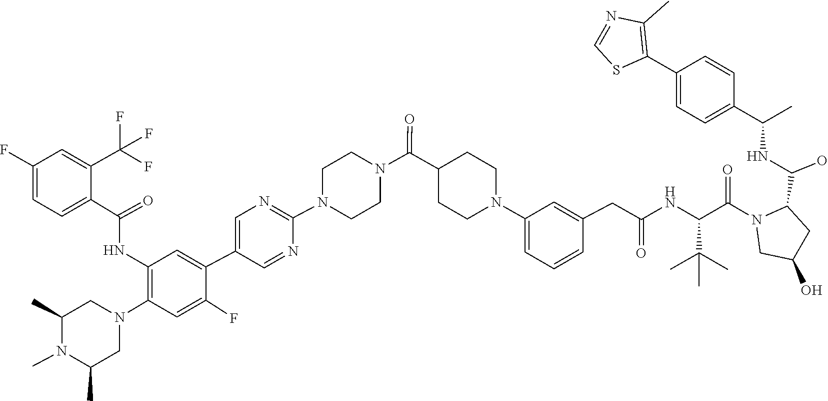 |
| B-37 | 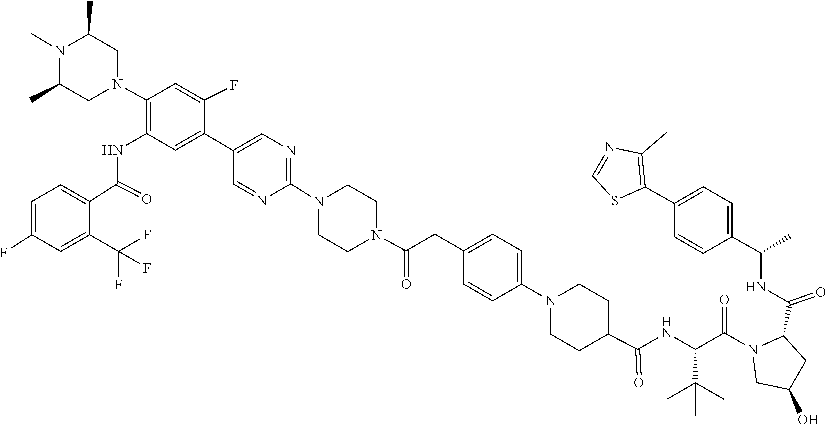 [SMILES: Cc1ncsc1-c1ccc([C@H](C)NC(=O)[C@@H]2C[C@@H](O)CN2C(=O)[C@@H](NC(=O)C2CCN(c3ccc(CC(=O)N4CCN(c5ncc(-c6cc(NC(=O)c7ccc(F)cc7C(F)(F)F)c(N7C[C@@H](C)N(C)[C@@H](C)C7)cc6F)cn5)CC4)cc3)CC2)C(C)(C)C)cc1] |
| B-38 | 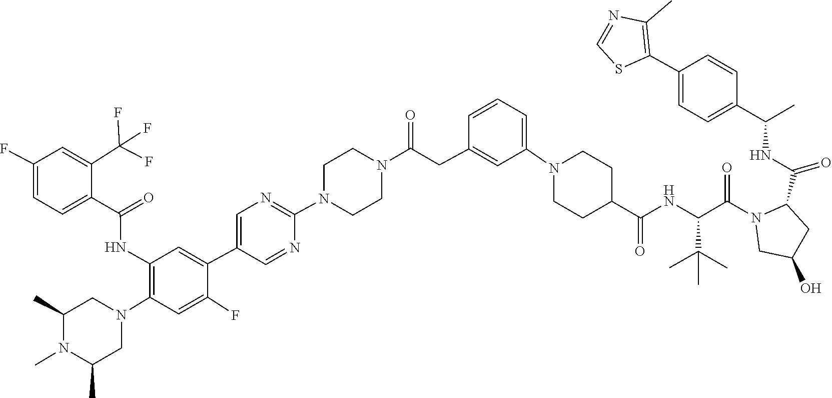 [SMILES: Cc1ncsc1-c1ccc([C@H](C)NC(=O)[C@@H]2C[C@@H](O)CN2C(=O)[C@@H](NC(=O)C2CCN(c3cccc(CC(=O)N4CCN(c5ncc(-c6cc(NC(=O)c7ccc(F)cc7C(F)(F)F)c(N7C[C@@H](C)N(C)[C@@H](C)C7)cc6F)cn5)CC4)c3)CC2)C(C)(C)C)cc1] |
| B-39 | 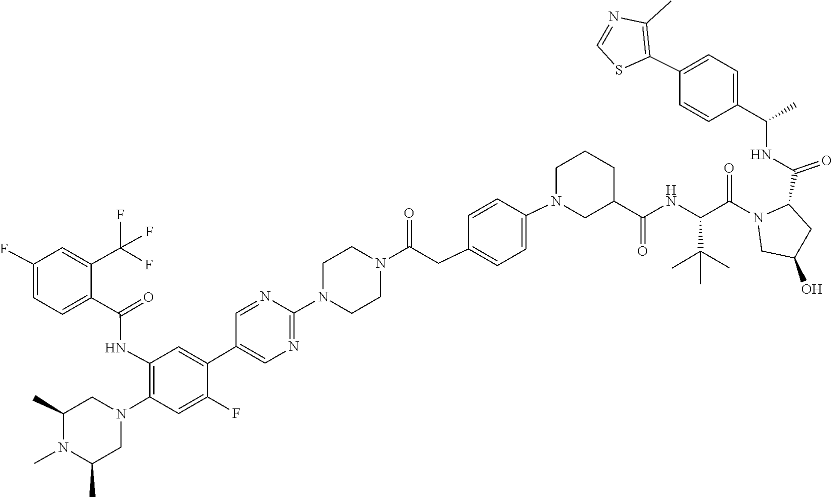 [SMILES: Cc1ncsc1-c1ccc([C@H](C)NC(=O)[C@@H]2C[C@@H](O)CN2C(=O)[C@@H](NC(=O)C2CCCN(c3ccc(CC(=O)N4CCN(c5ncc(-c6cc(NC(=O)c7ccc(F)cc7C(F)(F)F)c(N7C[C@@H](C)N(C)[C@@H](C)C7)cc6F)cn5)CC4)cc3)C2)C(C)(C)C)cc1] |
| B-40 | 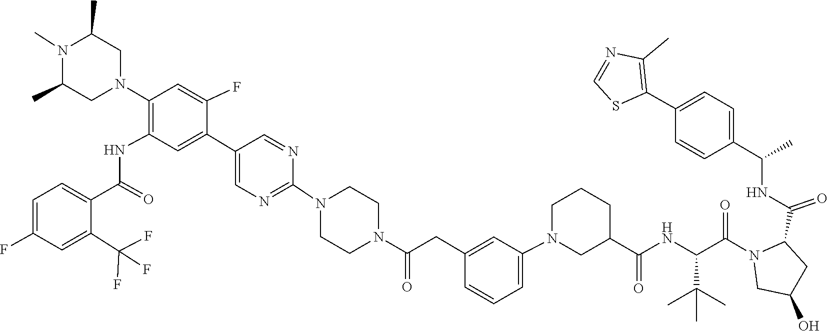 [SMILES: Cc1ncsc1-c1ccc([C@H](C)NC(=O)[C@@H]2C[C@@H](O)CN2C(=O)[C@@H](NC(=O)C2CCCN(c3cccc(CC(=O)N4CCN(c5ncc(-c6cc(NC(=O)c7ccc(F)cc7C(F)(F)F)c(N7C[C@@H](C)N(C)[C@@H](C)C7)cc6F)cn5)CC4)c3)C2)C(C)(C)C)cc1] |
| B-41 | 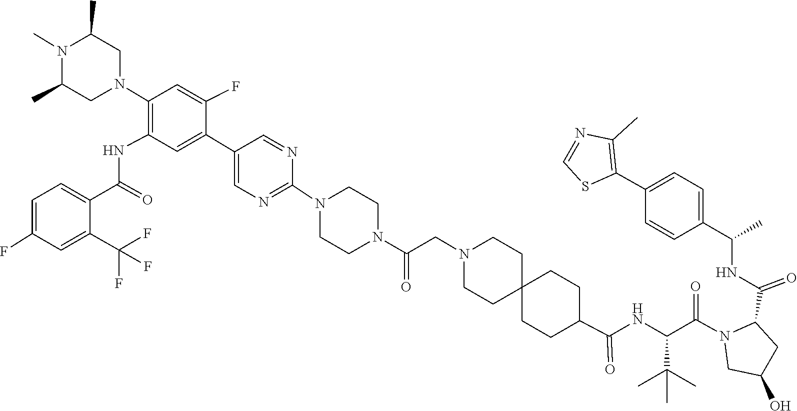 [SMILES: Cc1ncsc1-c1ccc([C@H](C)NC(=O)[C@@H]2C[C@@H](O)CN2C(=O)[C@@H](NC(=O)C2CCC3(CC2)CCN(CC(=O)N2CCN(c4ncc(-c5cc(NC(=O)c6ccc(F)cc6C(F)(F)F)c(N6C[C@@H](C)N(C)[C@@H](C)C6)cc5F)cn4)CC2)CC3)C(C)(C)C)cc1] |
| B-42 | 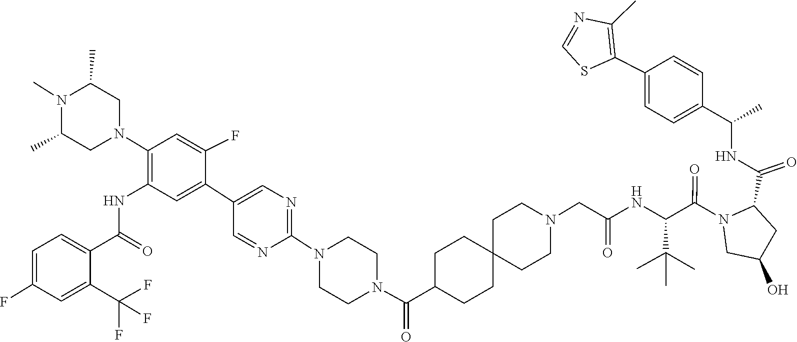 [SMILES: Cc1ncsc1-c1ccc([C@H](C)NC(=O)[C@@H]2C[C@@H](O)CN2C(=O)[C@@H](NC(=O)CN2CCC3(CCC(C(=O)N4CCN(c5ncc(-c6cc(NC(=O)c7ccc(F)cc7C(F)(F)F)c(N7C[C@@H](C)N(C)[C@@H](C)C7)cc6F)cn5)CC4)CC3)CC2)C(C)(C)C)cc1] |
| B-43 | 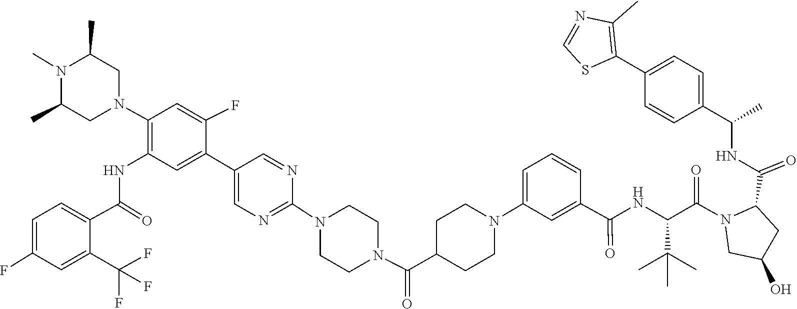 [SMILES: Cc1ncsc1-c1ccc([C@H](C)NC(=O)[C@@H]2C[C@@H](O)CN2C(=O)[C@@H](NC(=O)c2cccc(N3CCC(C(=O)N4CCN(c5ncc(-c6cc(NC(=O)c7ccc(F)cc7C(F)(F)F)c(N7C[C@@H](C)N(C)[C@@H](C)C7)cc6F)cn5)CC4)CC3)c2)C(C)(C)C)cc1] |
| B-44 | 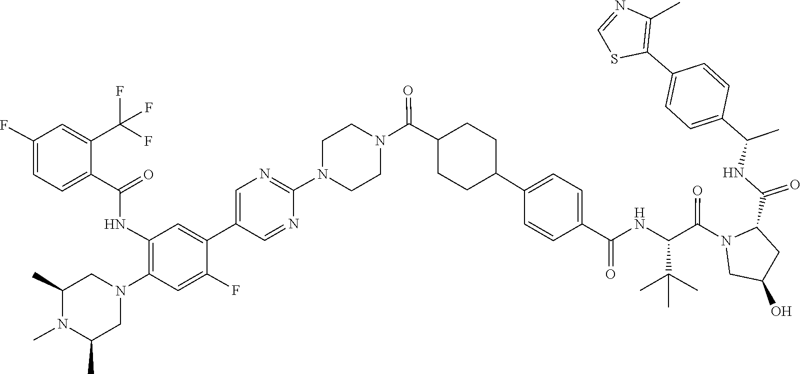 [SMILES: Cc1ncsc1-c1ccc([C@H](C)NC(=O)[C@@H]2C[C@@H](O)CN2C(=O)[C@@H](NC(=O)c2ccc(C3CCC(C(=O)N4CCN(c5ncc(-c6cc(NC(=O)c7ccc(F)cc7C(F)(F)F)c(N7C[C@@H](C)N(C)[C@@H](C)C7)cc6F)cn5)CC4)CC3)cc2)C(C)(C)C)cc1] |
| B-45 | 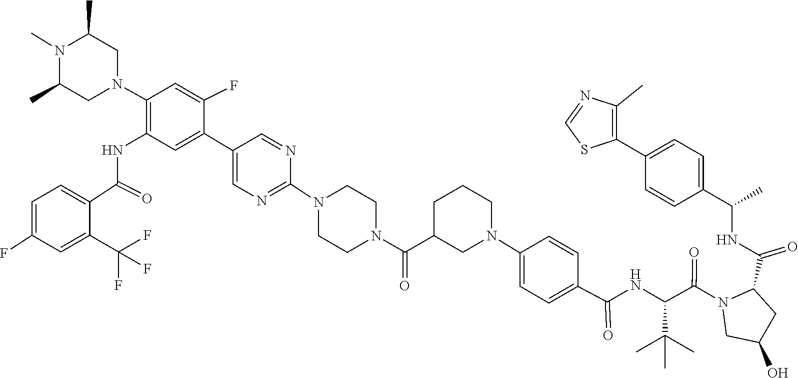 [SMILES: Cc1ncsc1-c1ccc([C@H](C)NC(=O)[C@@H]2C[C@@H](O)CN2C(=O)[C@@H](NC(=O)c2ccc(N3CCCC(C(=O)N4CCN(c5ncc(-c6cc(NC(=O)c7ccc(F)cc7C(F)(F)F)c(N7C[C@@H](C)N(C)[C@@H](C)C7)cc6F)cn5)CC4)C3)cc2)C(C)(C)C)cc1] |
| B-46 | 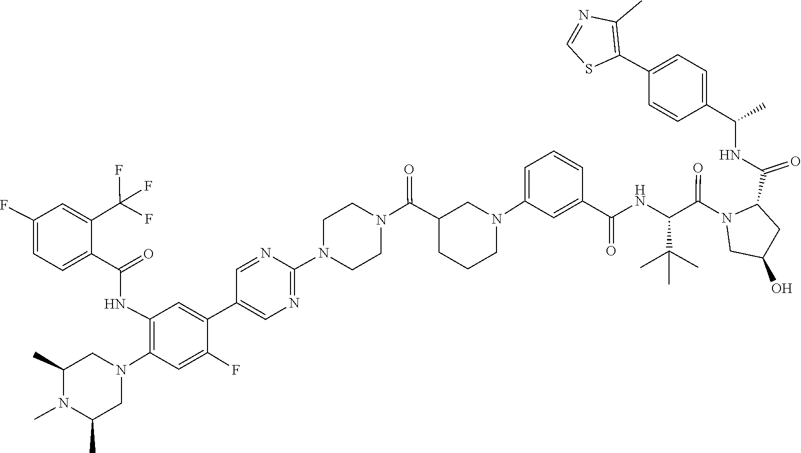 [SMILES: Cc1ncsc1-c1ccc([C@H](C)NC(=O)[C@@H]2C[C@@H](O)CN2C(=O)[C@@H](NC(=O)c2cccc(N3CCCC(C(=O)N4CCN(c5ncc(-c6cc(NC(=O)c7ccc(F)cc7C(F)(F)F)c(N7C[C@@H](C)N(C)[C@@H](C)C7)cc6F)cn5)CC4)C3)c2)C(C)(C)C)cc1] |
| B-47 | 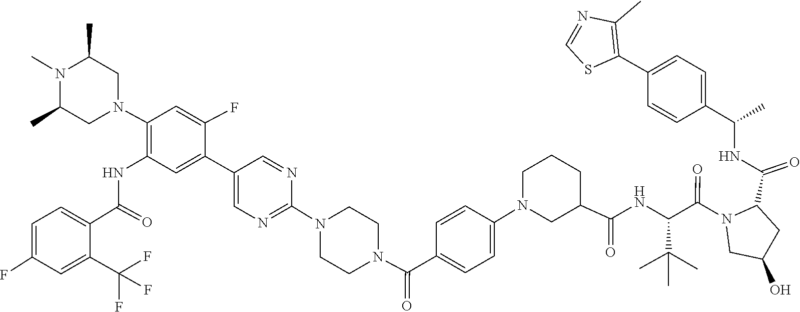 |
| B-48 | 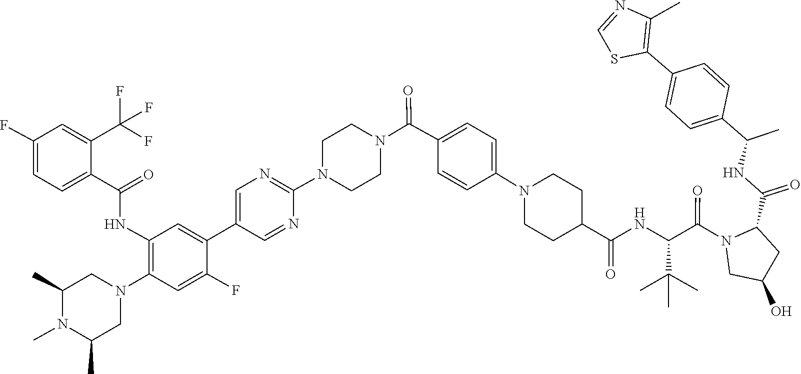 [SMILES: Cc1ncsc1-c1ccc([C@H](C)NC(=O)[C@@H]2C[C@@H](O)CN2C(=O)[C@@H](NC(=O)C2CCN(c3ccc(C(=O)N4CCN(c5ncc(-c6cc(NC(=O)c7ccc(F)cc7C(F)(F)F)c(N7C[C@@H](C)N(C)[C@@H](C)C7)cc6F)cn5)CC4)cc3)CC2)C(C)(C)C)cc1] |
| B-49 | 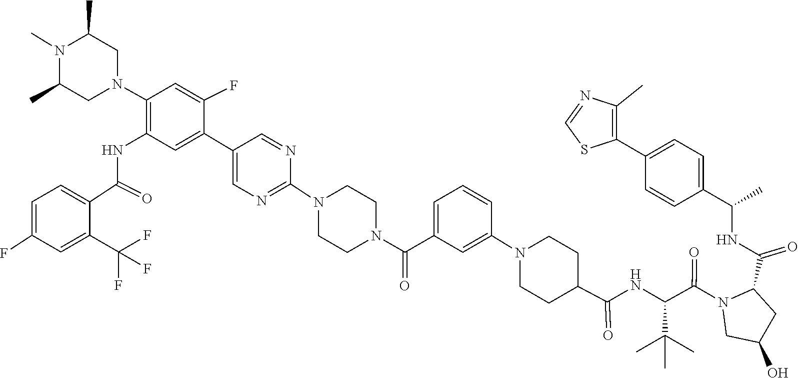 [SMILES: Cc1ncsc1-c1ccc([C@H](C)NC(=O)[C@@H]2C[C@@H](O)CN2C(=O)[C@@H](NC(=O)C2CCN(c3cccc(C(=O)N4CCN(c5ncc(-c6cc(NC(=O)c7ccc(F)cc7C(F)(F)F)c(N7C[C@@H](C)N(C)[C@@H](C)C7)cc6F)cn5)CC4)c3)CC2)C(C)(C)C)cc1] |
| B-50 | 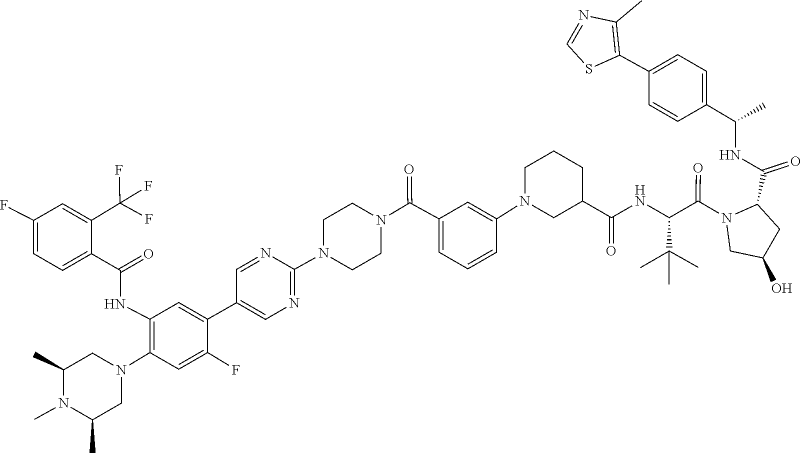 [SMILES: Cc1ncsc1-c1ccc([C@H](C)NC(=O)[C@@H]2C[C@@H](O)CN2C(=O)[C@@H](NC(=O)C2CCCN(c3cccc(C(=O)N4CCN(c5ncc(-c6cc(NC(=O)c7ccc(F)cc7C(F)(F)F)c(N7C[C@@H](C)N(C)[C@@H](C)C7)cc6F)cn5)CC4)c3)C2)C(C)(C)C)cc1] |
| B-51 | 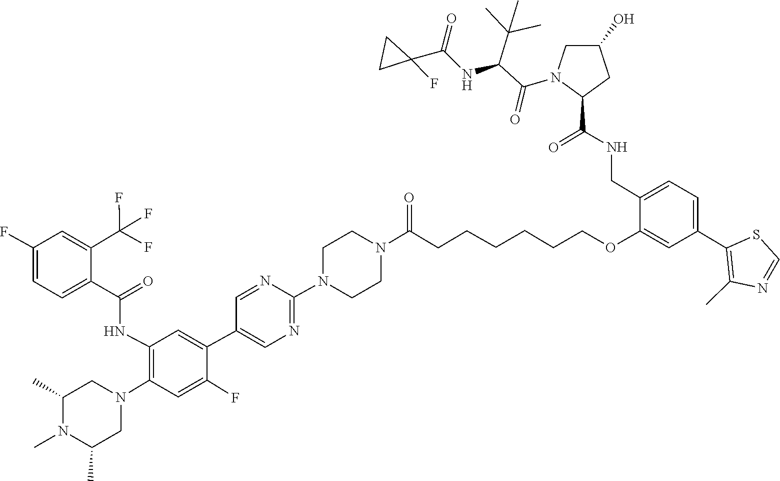 [SMILES: Cc1ncsc1-c1ccc(CNC(=O)[C@@H]2C[C@@H](O)CN2C(=O)[C@@H](NC(=O)C2(F)CC2)C(C)(C)C)c(OCCCCCCC(=O)N2CCN(c3ncc(-c4cc(NC(=O)c5ccc(F)cc5C(F)(F)F)c(N5C[C@@H](C)N(C)[C@@H](C)C5)cc4F)cn3)CC2)c1] |
| B-52 | 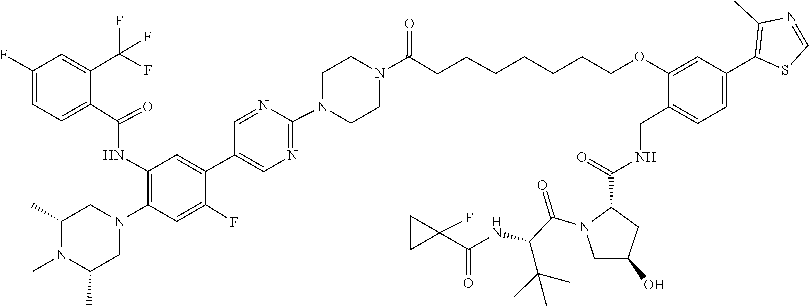 [SMILES: Cc1ncsc1-c1ccc(CNC(=O)[C@@H]2C[C@@H](O)CN2C(=O)[C@@H](NC(=O)C2(F)CC2)C(C)(C)C)c(OCCCCCCCC(=O)N2CCN(c3ncc(-c4cc(NC(=O)c5ccc(F)cc5C(F)(F)F)c(N5C[C@@H](C)N(C)[C@@H](C)C5)cc4F)cn3)CC2)c1] |
| B-53 | 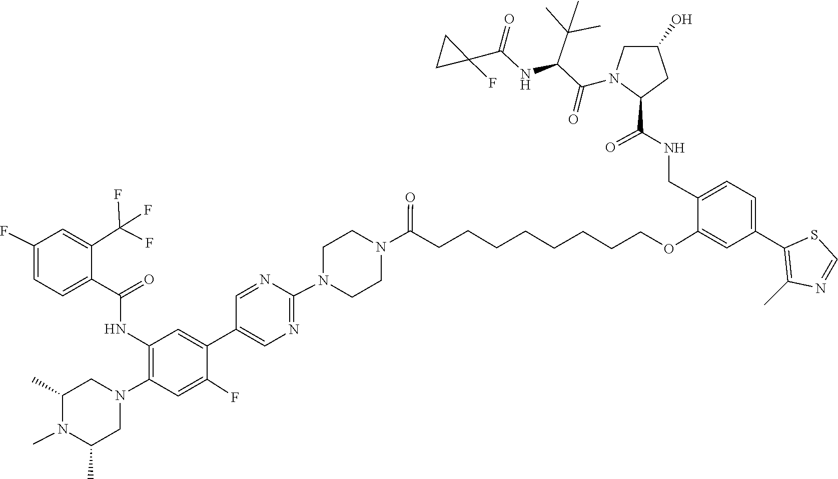 [SMILES: Cc1ncsc1-c1ccc(CNC(=O)[C@@H]2C[C@@H](O)CN2C(=O)[C@@H](NC(=O)C2(F)CC2)C(C)(C)C)c(OCCCCCCCCC(=O)N2CCN(c3ncc(-c4cc(NC(=O)c5ccc(F)cc5C(F)(F)F)c(N5C[C@@H](C)N(C)[C@@H](C)C5)cc4F)cn3)CC2)c1] |
| B-54 | 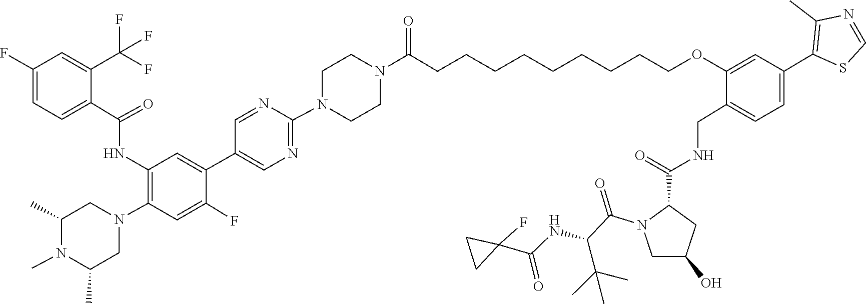 [SMILES: Cc1ncsc1-c1ccc(CNC(=O)[C@@H]2C[C@@H](O)CN2C(=O)[C@@H](NC(=O)C2(F)CC2)C(C)(C)C)c(OCCCCCCCCCC(=O)N2CCN(c3ncc(-c4cc(NC(=O)c5ccc(F)cc5C(F)(F)F)c(N5C[C@@H](C)N(C)[C@@H](C)C5)cc4F)cn3)CC2)c1] |
| B-55 | 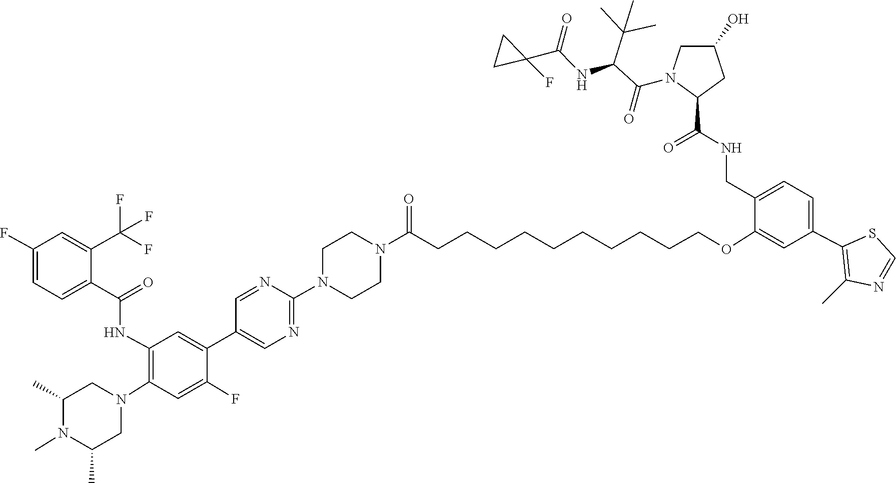 [SMILES: Cc1ncsc1-c1ccc(CNC(=O)[C@@H]2C[C@@H](O)CN2C(=O)[C@@H](NC(=O)C2(F)CC2)C(C)(C)C)c(OCCCCCCCCCCC(=O)N2CCN(c3ncc(-c4cc(NC(=O)c5ccc(F)cc5C(F)(F)F)c(N5C[C@@H](C)N(C)[C@@H](C)C5)cc4F)cn3)CC2)c1] |
| B-56 | 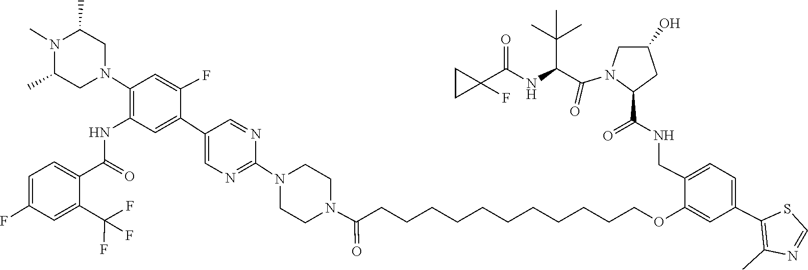 [SMILES: Cc1ncsc1-c1ccc(CNC(=O)[C@@H]2C[C@@H](O)CN2C(=O)[C@@H](NC(=O)C2(F)CC2)C(C)(C)C)c(OCCCCCCCCCCCC(=O)N2CCN(c3ncc(-c4cc(NC(=O)c5ccc(F)cc5C(F)(F)F)c(N5C[C@@H](C)N(C)[C@@H](C)C5)cc4F)cn3)CC2)c1] |
| B-57 | 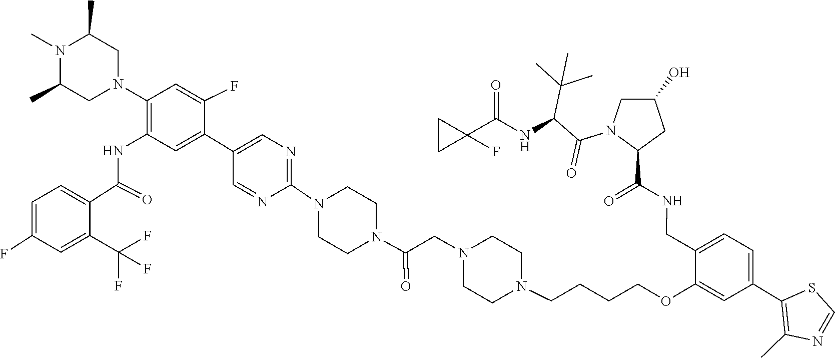 [SMILES: Cc1ncsc1-c1ccc(CNC(=O)[C@@H]2C[C@@H](O)CN2C(=O)[C@@H](NC(=O)C2(F)CC2)C(C)(C)C)c(OCCCCN2CCN(CC(=O)N3CCN(c4ncc(-c5cc(NC(=O)c6ccc(F)cc6C(F)(F)F)c(N6C[C@@H](C)N(C)[C@@H](C)C6)cc5F)cn4)CC3)CC2)c1] |
| B-58 | 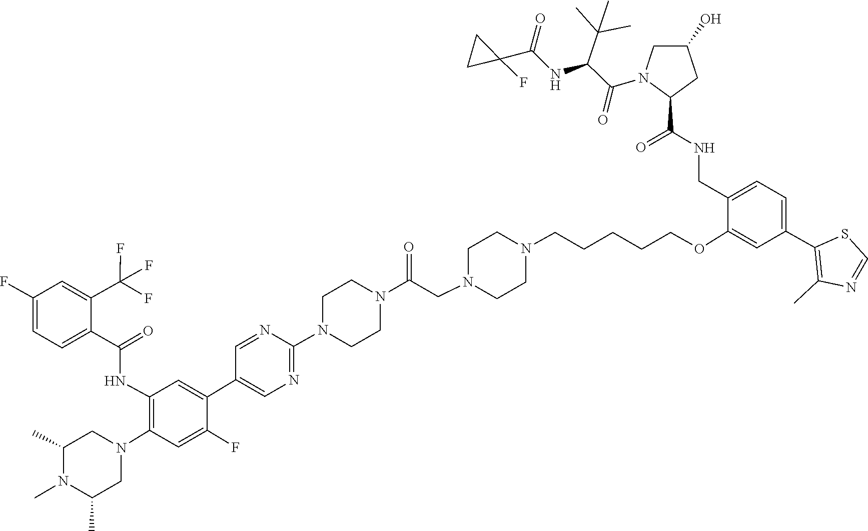 [SMILES: Cc1ncsc1-c1ccc(CNC(=O)[C@@H]2C[C@@H](O)CN2C(=O)[C@@H](NC(=O)C2(F)CC2)C(C)(C)C)c(OCCCCCN2CCN(CC(=O)N3CCN(c4ncc(-c5cc(NC(=O)c6ccc(F)cc6C(F)(F)F)c(N6C[C@@H](C)N(C)[C@@H](C)C6)cc5F)cn4)CC3)CC2)c1] |
| B-59 | 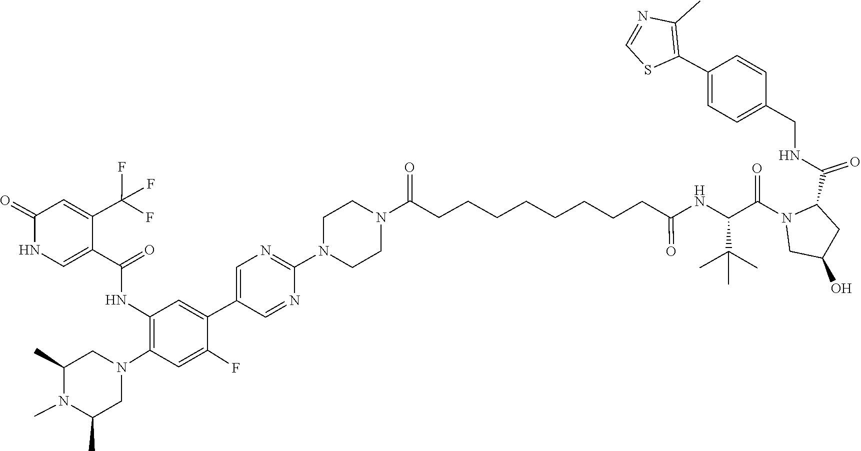 [SMILES: Cc1ncsc1-c1ccc(CNC(=O)[C@@H]2C[C@@H](O)CN2C(=O)[C@@H](NC(=O)CCCCCCCCC(=O)N2CCN(c3ncc(-c4cc(NC(=O)c5c[nH]c(=O)cc5C(F)(F)F)c(N5C[C@@H](C)N(C)[C@@H](C)C5)cc4F)cn3)CC2)C(C)(C)C)cc1] |
| B-60 | 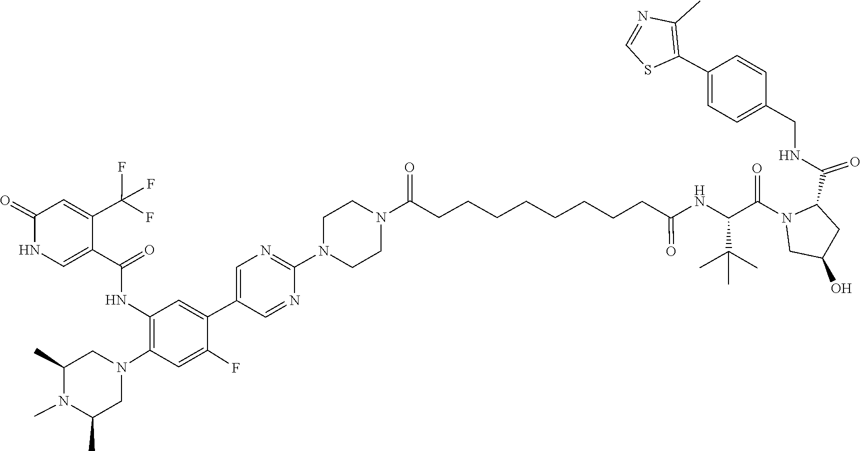 [SMILES: Cc1ncsc1-c1ccc(CNC(=O)[C@@H]2C[C@@H](O)CN2C(=O)[C@@H](NC(=O)CCCCCCCCC(=O)N2CCN(c3ncc(-c4cc(NC(=O)c5c[nH]c(=O)cc5C(F)(F)F)c(N5C[C@@H](C)N(C)[C@@H](C)C5)cc4F)cn3)CC2)C(C)(C)C)cc1] |
| B-61 | 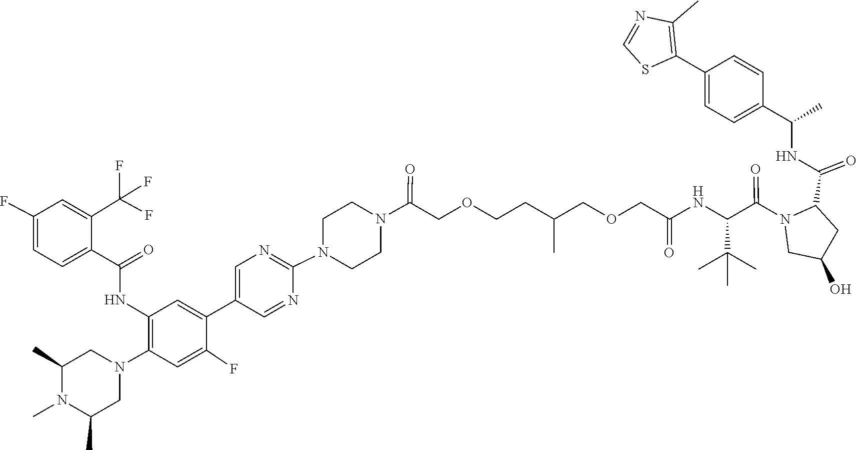 |
| B-62 | 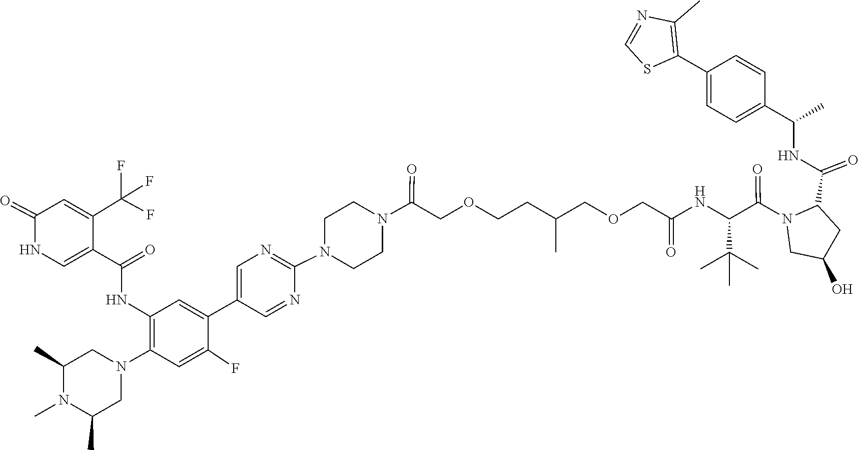 |
| B-63 | 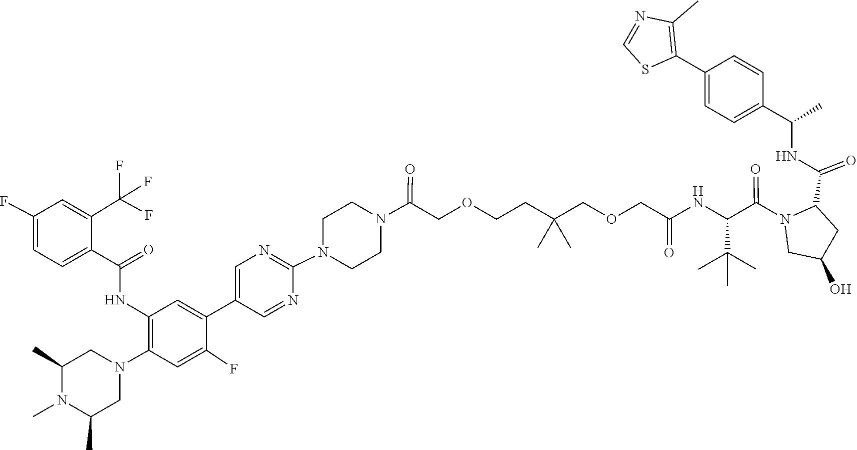 |
| B-64 | 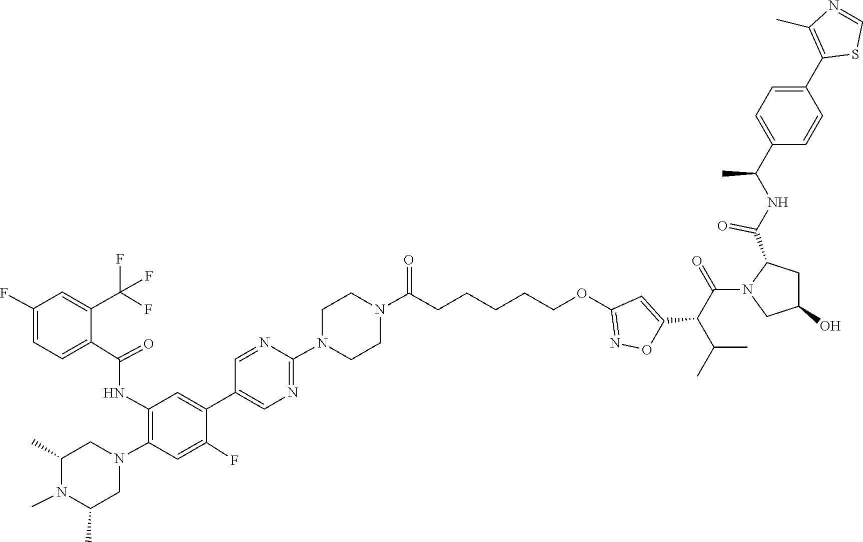 [SMILES: Cc1ncsc1-c1ccc([C@H](C)NC(=O)[C@@H]2C[C@@H](O)CN2C(=O)[C@@H](c2cc(OCCCCCC(=O)N3CCN(c4ncc(-c5cc(NC(=O)c6ccc(F)cc6C(F)(F)F)c(N6C[C@@H](C)N(C)[C@@H](C)C6)cc5F)cn4)CC3)no2)C(C)C)cc1] |
| B-65 | 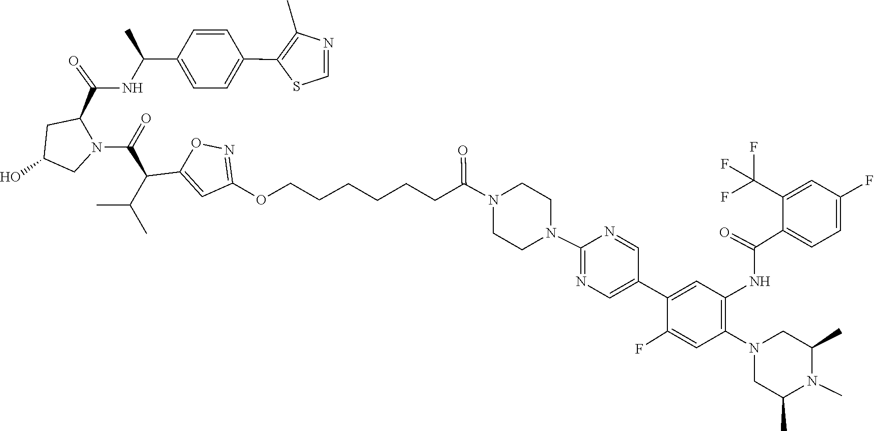 [SMILES: Cc1ncsc1-c1ccc([C@H](C)NC(=O)[C@@H]2C[C@@H](O)CN2C(=O)[C@@H](c2cc(OCCCCCCC(=O)N3CCN(c4ncc(-c5cc(NC(=O)c6ccc(F)cc6C(F)(F)F)c(N6C[C@@H](C)N(C)[C@@H](C)C6)cc5F)cn4)CC3)no2)C(C)C)cc1] |
| B-66 | 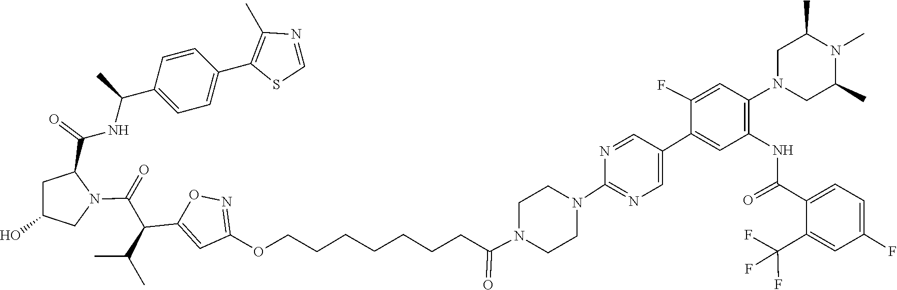 [SMILES: Cc1ncsc1-c1ccc([C@H](C)NC(=O)[C@@H]2C[C@@H](O)CN2C(=O)[C@@H](c2cc(OCCCCCCCC(=O)N3CCN(c4ncc(-c5cc(NC(=O)c6ccc(F)cc6C(F)(F)F)c(N6C[C@@H](C)N(C)[C@@H](C)C6)cc5F)cn4)CC3)no2)C(C)C)cc1] |
| B-67 | 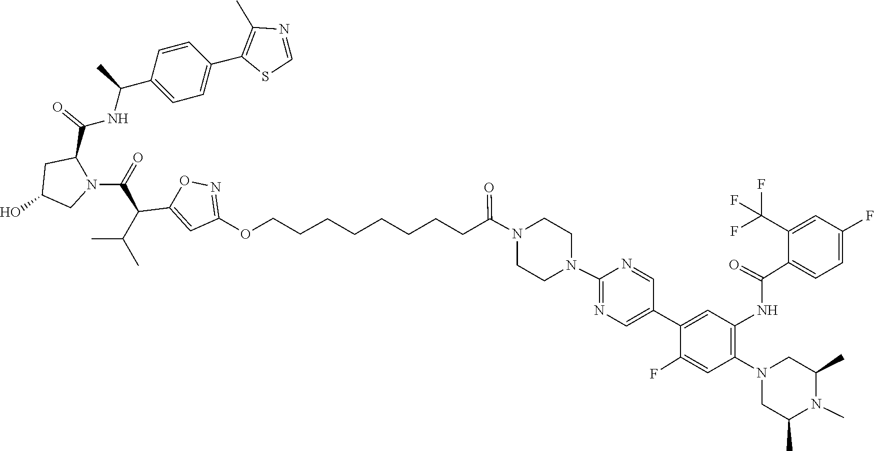 [SMILES: Cc1ncsc1-c1ccc([C@H](C)NC(=O)[C@@H]2C[C@@H](O)CN2C(=O)[C@@H](c2cc(OCCCCCCCCC(=O)N3CCN(c4ncc(-c5cc(NC(=O)c6ccc(F)cc6C(F)(F)F)c(N6C[C@@H](C)N(C)[C@@H](C)C6)cc5F)cn4)CC3)no2)C(C)C)cc1] |
| B-68 | 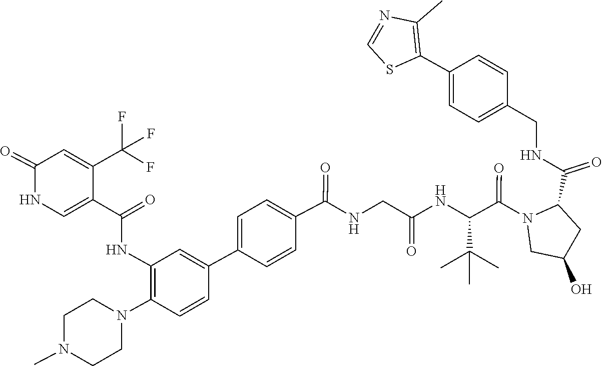 [SMILES: Cc1ncsc1-c1ccc(CNC(=O)[C@@H]2C[C@@H](O)CN2C(=O)[C@@H](NC(=O)CNC(=O)c2ccc(-c3ccc(N4CCN(C)CC4)c(NC(=O)c4c[nH]c(=O)cc4C(F)(F)F)c3)cc2)C(C)(C)C)cc1] |
| B-69 | 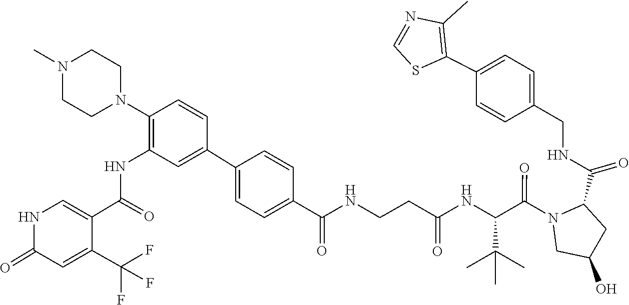 [SMILES: Cc1ncsc1-c1ccc(CNC(=O)[C@@H]2C[C@@H](O)CN2C(=O)[C@@H](NC(=O)CCNC(=O)c2ccc(-c3ccc(N4CCN(C)CC4)c(NC(=O)c4c[nH]c(=O)cc4C(F)(F)F)c3)cc2)C(C)(C)C)cc1] |
| B-70 | 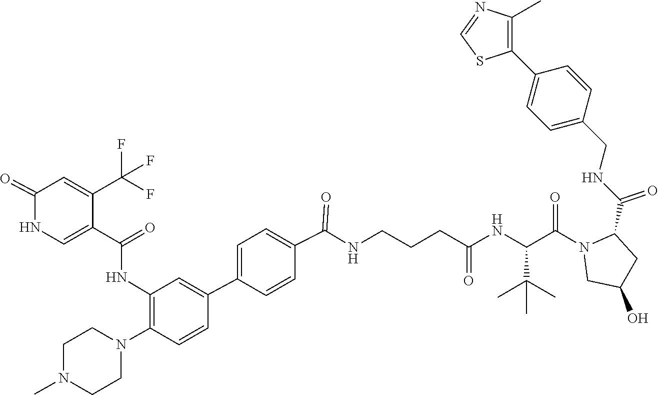 [SMILES: Cc1ncsc1-c1ccc(CNC(=O)[C@@H]2C[C@@H](O)CN2C(=O)[C@@H](NC(=O)CCCNC(=O)c2ccc(-c3ccc(N4CCN(C)CC4)c(NC(=O)c4c[nH]c(=O)cc4C(F)(F)F)c3)cc2)C(C)(C)C)cc1] |
| B-71 | 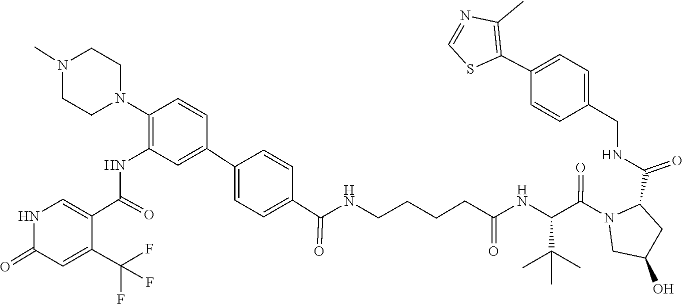 [SMILES: Cc1ncsc1-c1ccc(CNC(=O)[C@@H]2C[C@@H](O)CN2C(=O)[C@@H](NC(=O)CCCCNC(=O)c2ccc(-c3ccc(N4CCN(C)CC4)c(NC(=O)c4c[nH]c(=O)cc4C(F)(F)F)c3)cc2)C(C)(C)C)cc1] |
| B-72 | 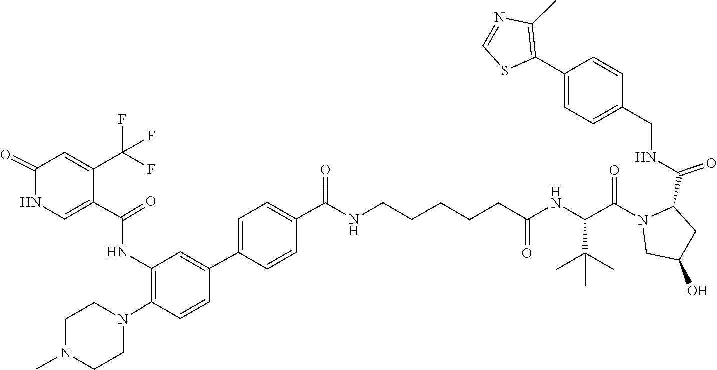 [SMILES: Cc1ncsc1-c1ccc(CNC(=O)[C@@H]2C[C@@H](O)CN2C(=O)[C@@H](NC(=O)CCCCCNC(=O)c2ccc(-c3ccc(N4CCN(C)CC4)c(NC(=O)c4c[nH]c(=O)cc4C(F)(F)F)c3)cc2)C(C)(C)C)cc1] |
| B-73 | 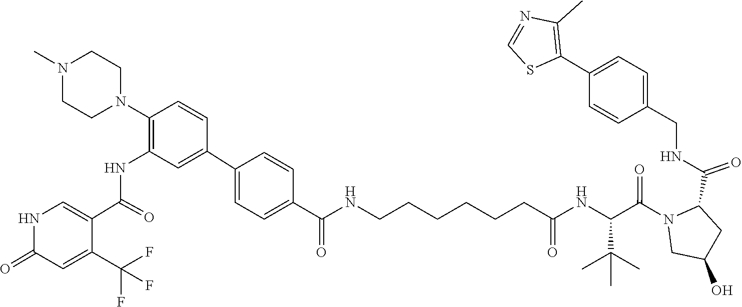 [SMILES: Cc1ncsc1-c1ccc(CNC(=O)[C@@H]2C[C@@H](O)CN2C(=O)[C@@H](NC(=O)CCCCCCNC(=O)c2ccc(-c3ccc(N4CCN(C)CC4)c(NC(=O)c4c[nH]c(=O)cc4C(F)(F)F)c3)cc2)C(C)(C)C)cc1] |
| B-74 | 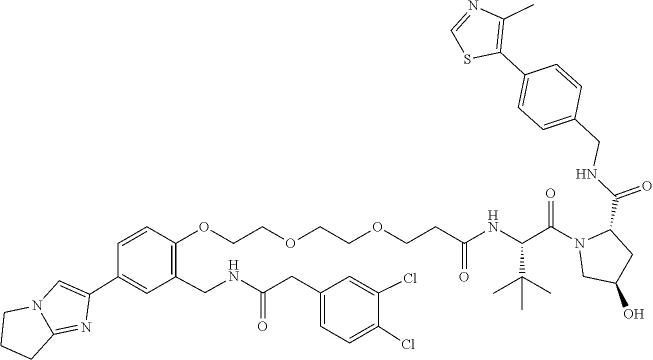 [SMILES: Cc1ncsc1-c1ccc(CNC(=O)[C@@H]2C[C@@H](O)CN2C(=O)[C@@H](NC(=O)CCOCCOCCOc2ccc(-c3cn4c(n3)CCC4)cc2CNC(=O)Cc2ccc(Cl)c(Cl)c2)C(C)(C)C)cc1] |
| B-75 | 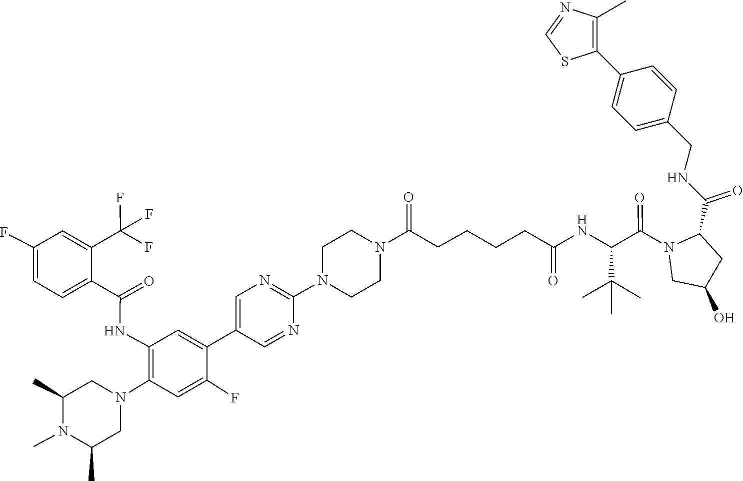 [SMILES: Cc1ncsc1-c1ccc(CNC(=O)[C@@H]2C[C@@H](O)CN2C(=O)[C@@H](NC(=O)CCCCC(=O)N2CCN(c3ncc(-c4cc(NC(=O)c5ccc(F)cc5C(F)(F)F)c(N5C[C@@H](C)N(C)[C@@H](C)C5)cc4F)cn3)CC2)C(C)(C)C)cc1] |
| B-76 | 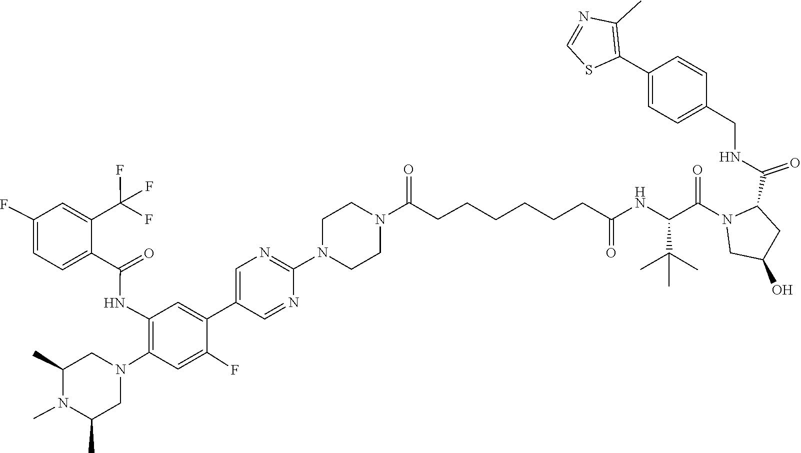 [SMILES: Cc1ncsc1-c1ccc(CNC(=O)[C@@H]2C[C@@H](O)CN2C(=O)[C@@H](NC(=O)CCCCCCC(=O)N2CCN(c3ncc(-c4cc(NC(=O)c5ccc(F)cc5C(F)(F)F)c(N5C[C@@H](C)N(C)[C@@H](C)C5)cc4F)cn3)CC2)C(C)(C)C)cc1] |
| B-77 | 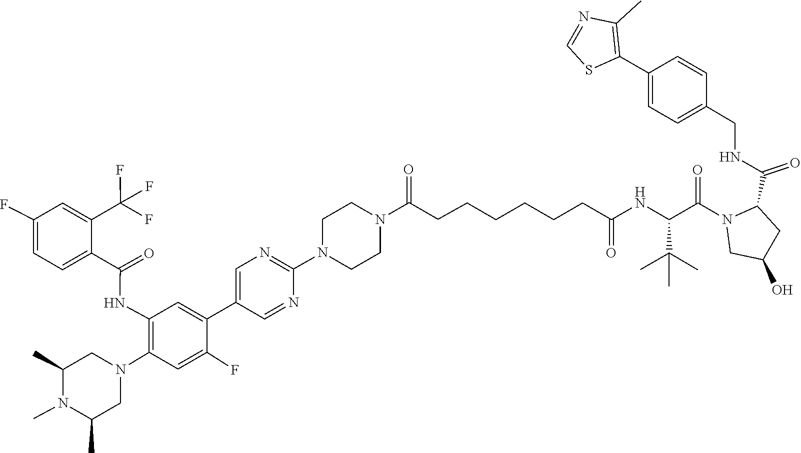 [SMILES: Cc1ncsc1-c1ccc(CNC(=O)[C@@H]2C[C@@H](O)CN2C(=O)[C@@H](NC(=O)CCCCCCC(=O)N2CCN(c3ncc(-c4cc(NC(=O)c5ccc(F)cc5C(F)(F)F)c(N5C[C@@H](C)N(C)[C@@H](C)C5)cc4F)cn3)CC2)C(C)(C)C)cc1] |
| B-78 | 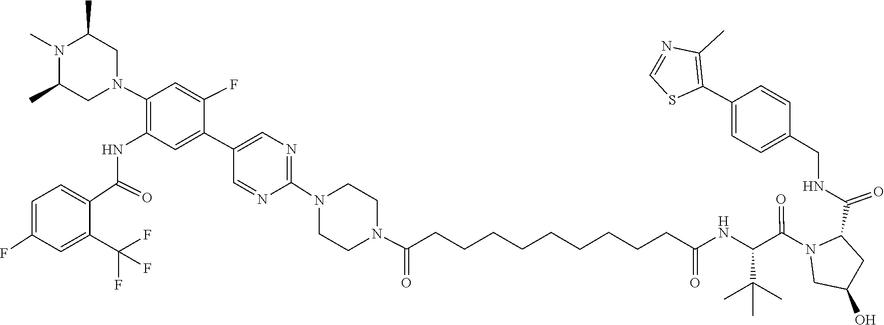 [SMILES: Cc1ncsc1-c1ccc(CNC(=O)[C@@H]2C[C@@H](O)CN2C(=O)[C@@H](NC(=O)CCCCCCCCCC(=O)N2CCN(c3ncc(-c4cc(NC(=O)c5ccc(F)cc5C(F)(F)F)c(N5C[C@@H](C)N(C)[C@@H](C)C5)cc4F)cn3)CC2)C(C)(C)C)cc1] |
| B-79 | 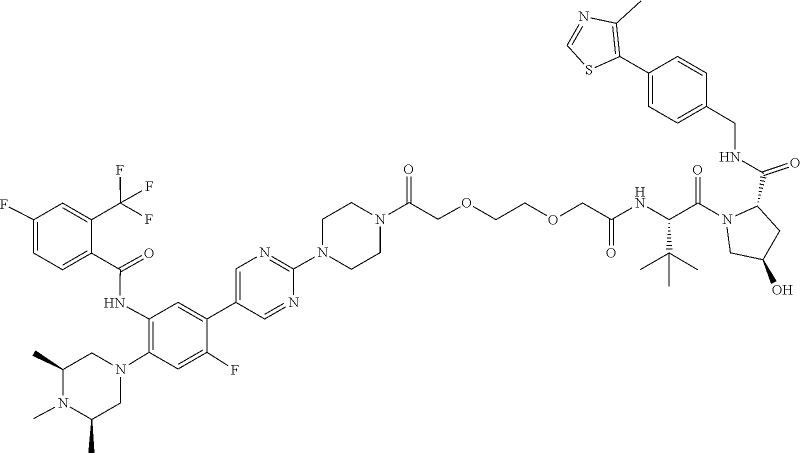 [SMILES: Cc1ncsc1-c1ccc(CNC(=O)[C@@H]2C[C@@H](O)CN2C(=O)[C@@H](NC(=O)COCCOCC(=O)N2CCN(c3ncc(-c4cc(NC(=O)c5ccc(F)cc5C(F)(F)F)c(N5C[C@@H](C)N(C)[C@@H](C)C5)cc4F)cn3)CC2)C(C)(C)C)cc1] |
| B-80 | 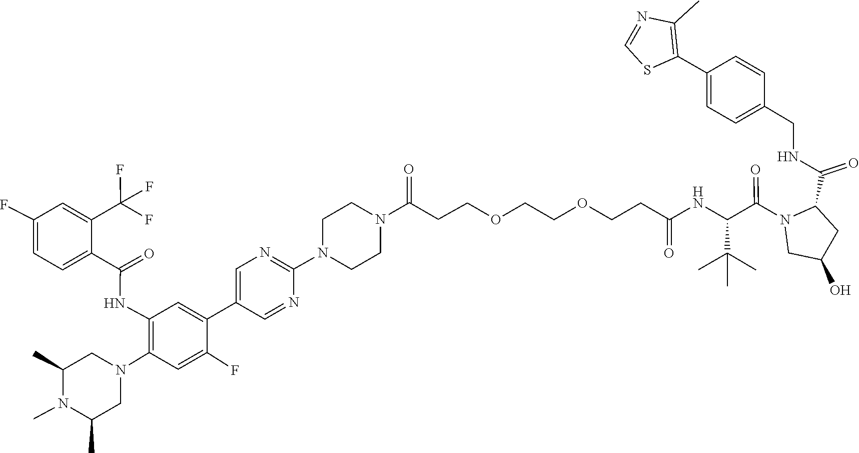 [SMILES: Cc1ncsc1-c1ccc(CNC(=O)[C@@H]2C[C@@H](O)CN2C(=O)[C@@H](NC(=O)CCOCCOCCC(=O)N2CCN(c3ncc(-c4cc(NC(=O)c5ccc(F)cc5C(F)(F)F)c(N5C[C@@H](C)N(C)[C@@H](C)C5)cc4F)cn3)CC2)C(C)(C)C)cc1] |
| B-81 | 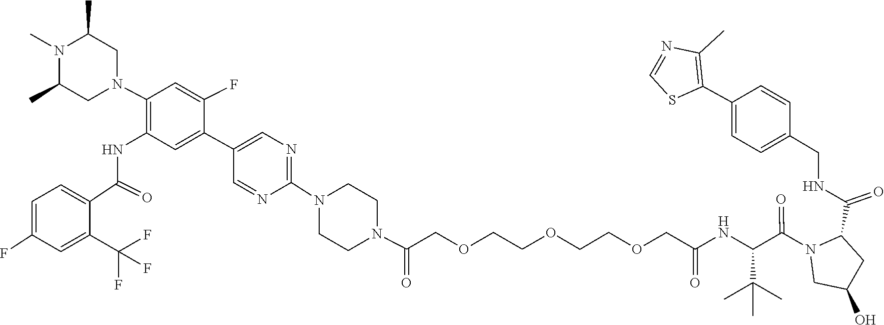 [SMILES: Cc1ncsc1-c1ccc(CNC(=O)[C@@H]2C[C@@H](O)CN2C(=O)[C@@H](NC(=O)COCCOCCOCC(=O)N2CCN(c3ncc(-c4cc(NC(=O)c5ccc(F)cc5C(F)(F)F)c(N5C[C@@H](C)N(C)[C@@H](C)C5)cc4F)cn3)CC2)C(C)(C)C)cc1] |
| B-82 | 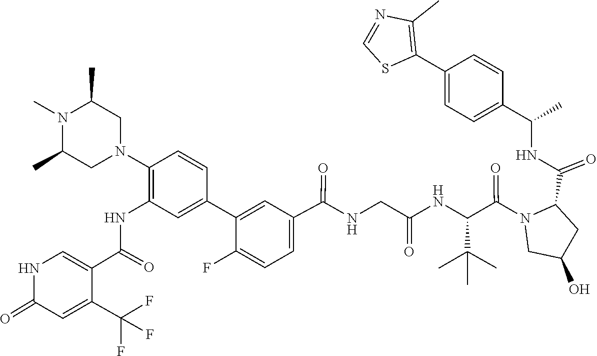 [SMILES: Cc1ncsc1-c1ccc([C@H](C)NC(=O)[C@@H]2C[C@@H](O)CN2C(=O)[C@@H](NC(=O)CNC(=O)c2ccc(F)c(-c3ccc(N4C[C@@H](C)N(C)[C@@H](C)C4)c(NC(=O)c4c[nH]c(=O)cc4C(F)(F)F)c3)c2)C(C)(C)C)cc1] |
| B-83 | 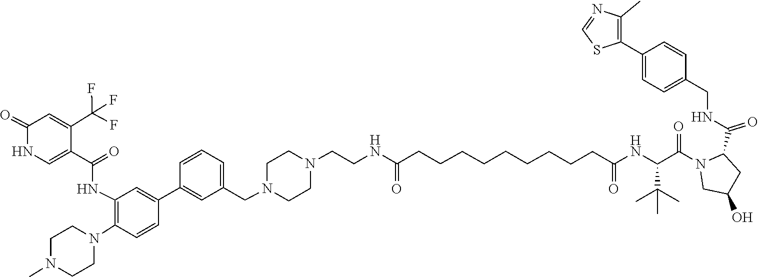 [SMILES: Cc1ncsc1-c1ccc(CNC(=O)[C@@H]2C[C@@H](O)CN2C(=O)[C@@H](NC(=O)CCCCCCCCCC(=O)NCCN2CCN(Cc3cccc(-c4ccc(N5CCN(C)CC5)c(NC(=O)c5c[nH]c(=O)cc5C(F)(F)F)c4)c3)CC2)C(C)(C)C)cc1] |
| B-84 | 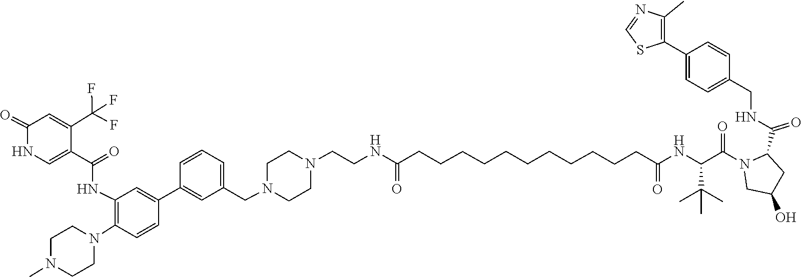 [SMILES: Cc1ncsc1-c1ccc(CNC(=O)[C@@H]2C[C@@H](O)CN2C(=O)[C@@H](NC(=O)CCCCCCCCCCCC(=O)NCCN2CCN(Cc3cccc(-c4ccc(N5CCN(C)CC5)c(NC(=O)c5c[nH]c(=O)cc5C(F)(F)F)c4)c3)CC2)C(C)(C)C)cc1] |
| B-85 | 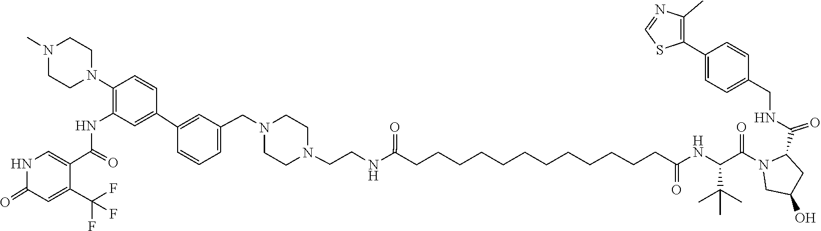 [SMILES: Cc1ncsc1-c1ccc(CNC(=O)[C@@H]2C[C@@H](O)CN2C(=O)[C@@H](NC(=O)CCCCCCCCCCCCC(=O)NCCN2CCN(Cc3cccc(-c4ccc(N5CCN(C)CC5)c(NC(=O)c5c[nH]c(=O)cc5C(F)(F)F)c4)c3)CC2)C(C)(C)C)cc1] |
| B-86 | 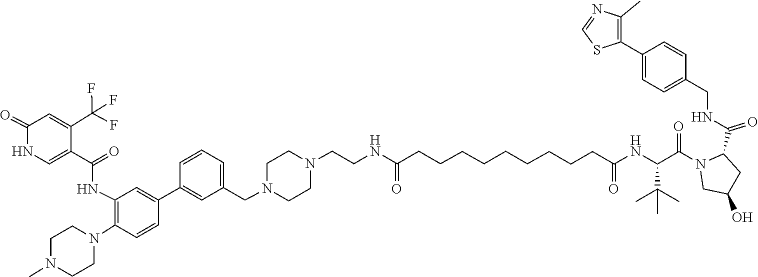 [SMILES: Cc1ncsc1-c1ccc(CNC(=O)[C@@H]2C[C@@H](O)CN2C(=O)[C@@H](NC(=O)CCCCCCCCCC(=O)NCCN2CCN(Cc3cccc(-c4ccc(N5CCN(C)CC5)c(NC(=O)c5c[nH]c(=O)cc5C(F)(F)F)c4)c3)CC2)C(C)(C)C)cc1] |
| B-87 | 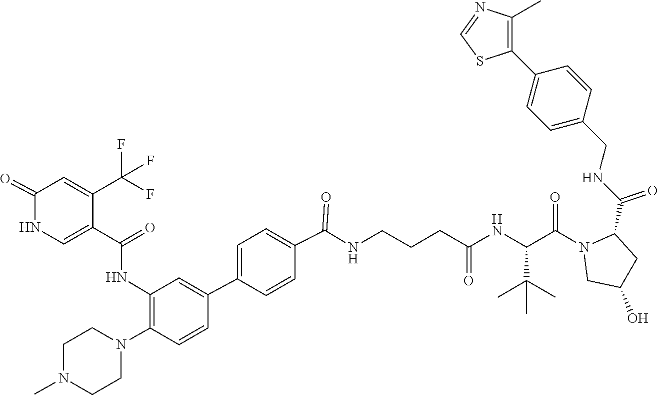 [SMILES: Cc1ncsc1-c1ccc(CNC(=O)[C@@H]2C[C@H](O)CN2C(=O)[C@@H](NC(=O)CCCNC(=O)c2ccc(-c3ccc(N4CCN(C)CC4)c(NC(=O)c4c[nH]c(=O)cc4C(F)(F)F)c3)cc2)C(C)(C)C)cc1] |
| B-88 | 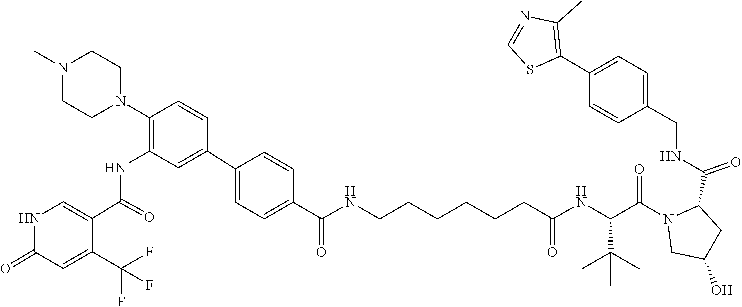 [SMILES: Cc1ncsc1-c1ccc(CNC(=O)[C@@H]2C[C@H](O)CN2C(=O)[C@@H](NC(=O)CCCCCCNC(=O)c2ccc(-c3ccc(N4CCN(C)CC4)c(NC(=O)c4c[nH]c(=O)cc4C(F)(F)F)c3)cc2)C(C)(C)C)cc1] |
| B-89 | 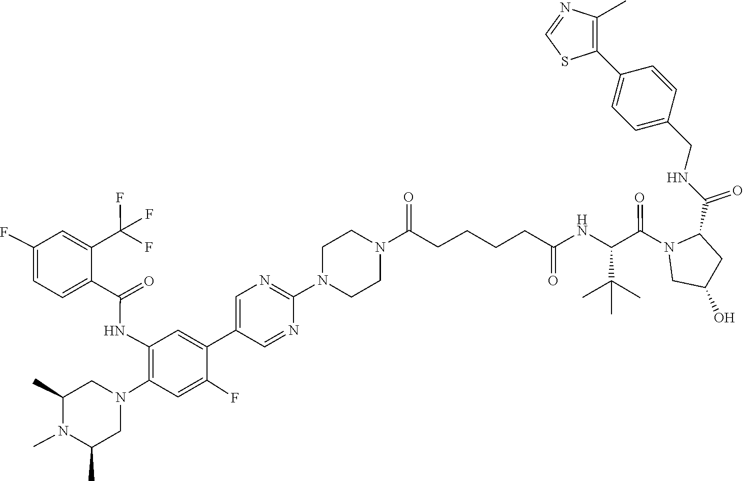 [SMILES: Cc1ncsc1-c1ccc(CNC(=O)[C@@H]2C[C@H](O)CN2C(=O)[C@@H](NC(=O)CCCCC(=O)N2CCN(c3ncc(-c4cc(NC(=O)c5ccc(F)cc5C(F)(F)F)c(N5C[C@@H](C)N(C)[C@@H](C)C5)cc4F)cn3)CC2)C(C)(C)C)cc1] |
| B-90 | 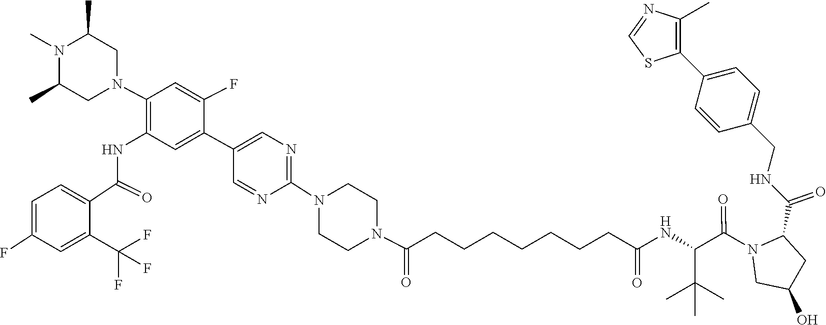 [SMILES: Cc1ncsc1-c1ccc(CNC(=O)[C@@H]2C[C@@H](O)CN2C(=O)[C@@H](NC(=O)CCCCCCCC(=O)N2CCN(c3ncc(-c4cc(NC(=O)c5ccc(F)cc5C(F)(F)F)c(N5C[C@@H](C)N(C)[C@@H](C)C5)cc4F)cn3)CC2)C(C)(C)C)cc1] |

Table 3 comprises bifunctional compounds having VHL ligase targeting moieties and BRD3 protein targeting moieties. The compounds set forth in Table 3 were synthesized as described in detail below in Examples C₁-C₅₆.

TABLE 3

| Ex- | |
|---|---|
| am- | |
| ple | Structure |
| C-1 | 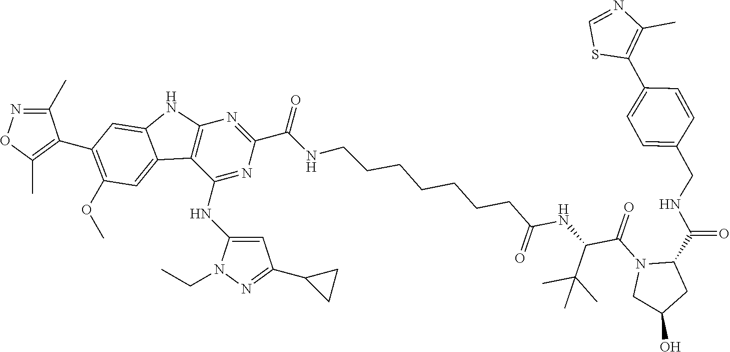 [SMILES: CCn1nc(C2CC2)cc1Nc1nc(C(=O)NCCCCCCCC(=O)N[C@H](C(=O)N2C[C@H](O)C[C@H]2C(=O)NCc2ccc(-c3scnc3C)cc2)C(C)(C)C)nc2[nH]c3cc(-c4c(C)noc4C)c(OC)cc3c12] |
| C-2 | 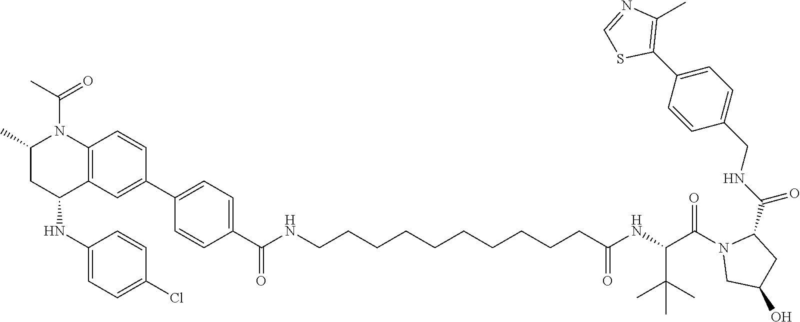 [SMILES: CC(=O)N1c2ccc(-c3ccc(C(=O)NCCCCCCCCCCC(=O)N[C@H](C(=O)N4C[C@H](O)C[C@H]4C(=O)NCc4ccc(-c5scnc5C)cc4)C(C)(C)C)cc3)cc2[C@H](Nc2ccc(Cl)cc2)C[C@@H]1C] |
| C-3 | 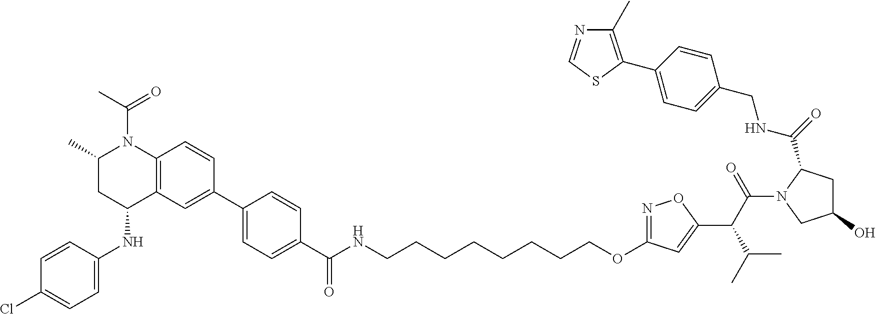 [SMILES: CC(=O)N1c2ccc(-c3ccc(C(=O)NCCCCCCCCOc4cc([C@H](C(=O)N5C[C@H](O)C[C@H]5C(=O)NCc5ccc(-c6scnc6C)cc5)C(C)C)on4)cc3)cc2[C@H](Nc2ccc(Cl)cc2)C[C@@H]1C] |
| C-4 | 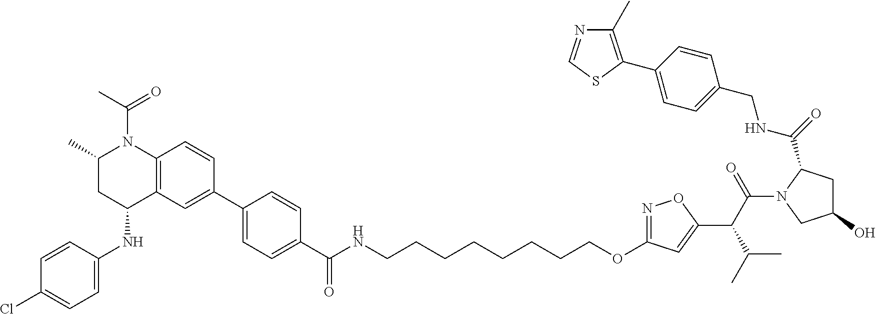 [SMILES: CC(=O)N1c2ccc(-c3ccc(C(=O)NCCCCCCCCOc4cc([C@H](C(=O)N5C[C@H](O)C[C@H]5C(=O)NCc5ccc(-c6scnc6C)cc5)C(C)C)on4)cc3)cc2[C@H](Nc2ccc(Cl)cc2)C[C@@H]1C] |
| C-5 | 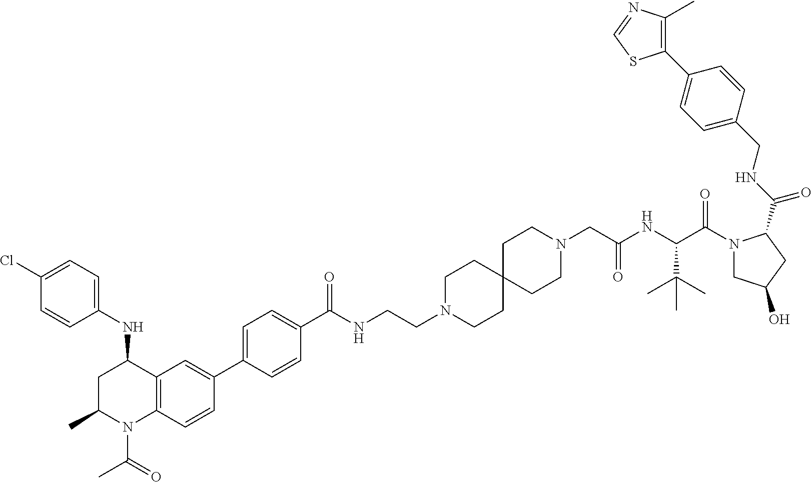 [SMILES: CC(=O)N1c2ccc(-c3ccc(C(=O)NCCN4CCC5(CC4)CCN(CC(=O)N[C@H](C(=O)N4C[C@H](O)C[C@H]4C(=O)NCc4ccc(-c6scnc6C)cc4)C(C)(C)C)CC5)cc3)cc2[C@H](Nc2ccc(Cl)cc2)C[C@@H]1C] |
| C-6 | 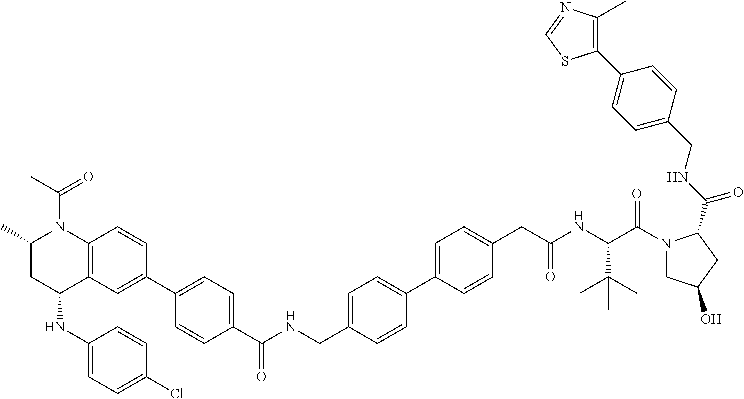 [SMILES: CC(=O)N1c2ccc(-c3ccc(C(=O)NCc4ccc(-c5ccc(CC(=O)N[C@H](C(=O)N6C[C@H](O)C[C@H]6C(=O)NCc6ccc(-c7scnc7C)cc6)C(C)(C)C)cc5)cc4)cc3)cc2[C@H](Nc2ccc(Cl)cc2)C[C@@H]1C] |
| C-7 | 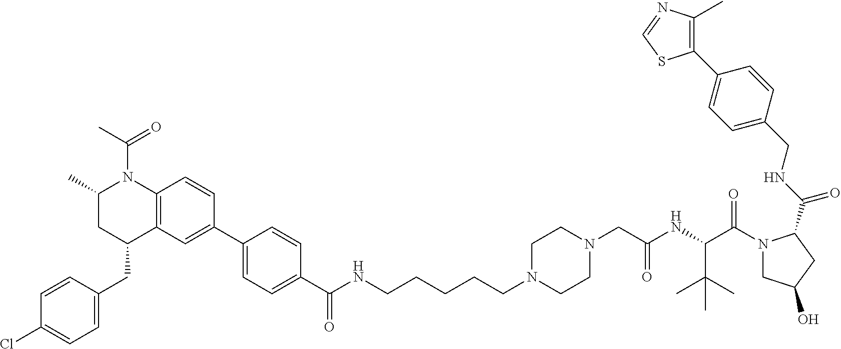 [SMILES: CC(=O)N1c2ccc(-c3ccc(C(=O)NCCCCCN4CCN(CC(=O)N[C@H](C(=O)N5C[C@H](O)C[C@H]5C(=O)NCc5ccc(-c6scnc6C)cc5)C(C)(C)C)CC4)cc3)cc2[C@H](Cc2ccc(Cl)cc2)C[C@@H]1C] |
| C-8 | 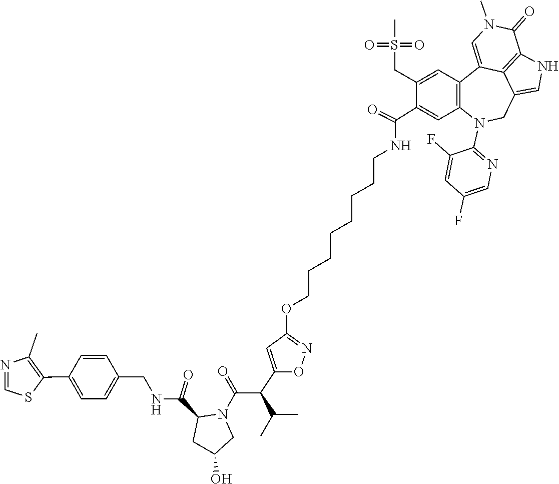 [SMILES: Cc1ncsc1-c1ccc(CNC(=O)[C@@H]2C[C@@H](O)CN2C(=O)[C@@H](c2cc(OCCCCCCCCNC(=O)c3cc4c(cc3CS(C)(=O)=O)-c3cn(C)c(=O)c5[nH]cc(c35)CN4c3ncc(F)cc3F)no2)C(C)C)cc1] |
| C-9 | 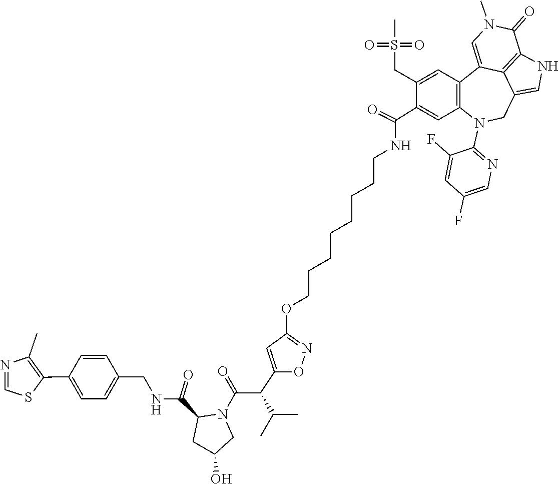 [SMILES: Cc1ncsc1-c1ccc(CNC(=O)[C@@H]2C[C@@H](O)CN2C(=O)[C@H](c2cc(OCCCCCCCCNC(=O)c3cc4c(cc3CS(C)(=O)=O)-c3cn(C)c(=O)c5[nH]cc(c35)CN4c3ncc(F)cc3F)no2)C(C)C)cc1] |
| C-10 | 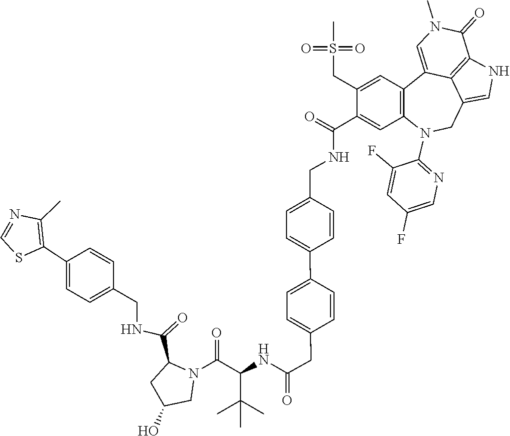 [SMILES: Cc1ncsc1-c1ccc(CNC(=O)[C@@H]2C[C@@H](O)CN2C(=O)[C@@H](NC(=O)Cc2ccc(-c3ccc(CNC(=O)c4cc5c(cc4CS(C)(=O)=O)-c4cn(C)c(=O)c6[nH]cc(c46)CN5c4ncc(F)cc4F)cc3)cc2)C(C)(C)C)cc1] |
| C-11 | 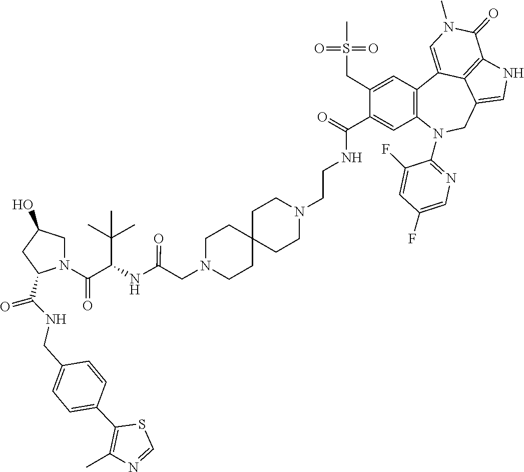 [SMILES: Cc1ncsc1-c1ccc(CNC(=O)[C@@H]2C[C@@H](O)CN2C(=O)[C@@H](NC(=O)CN2CCC3(CCN(CCNC(=O)c4cc5c(cc4CS(C)(=O)=O)-c4cn(C)c(=O)c6[nH]cc(c46)CN5c4ncc(F)cc4F)CC3)CC2)C(C)(C)C)cc1] |
| C-12 | 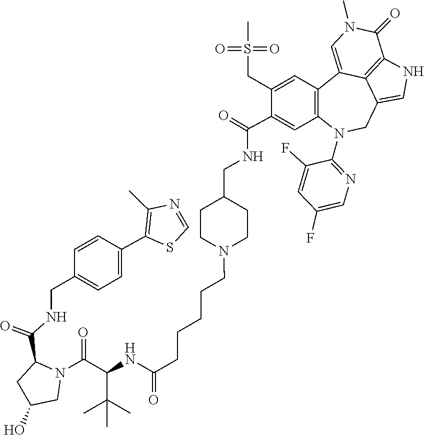 [SMILES: Cc1ncsc1-c1ccc(CNC(=O)[C@@H]2C[C@@H](O)CN2C(=O)[C@@H](NC(=O)CCCCCN2CCC(CNC(=O)c3cc4c(cc3CS(C)(=O)=O)-c3cn(C)c(=O)c5[nH]cc(c35)CN4c3ncc(F)cc3F)CC2)C(C)(C)C)cc1] |
| C-13 | 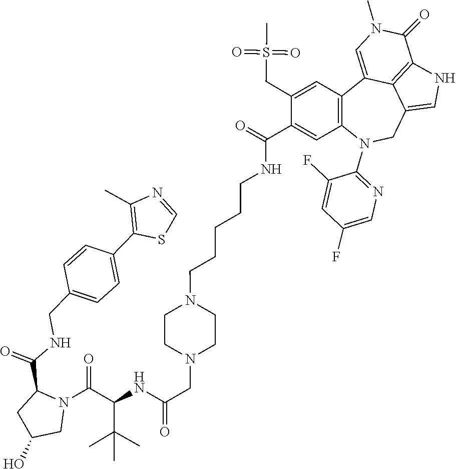 [SMILES: Cc1ncsc1-c1ccc(CNC(=O)[C@@H]2C[C@@H](O)CN2C(=O)[C@@H](NC(=O)CN2CCN(CCCCCNC(=O)c3cc4c(cc3CS(C)(=O)=O)-c3cn(C)c(=O)c5[nH]cc(c35)CN4c3ncc(F)cc3F)CC2)C(C)(C)C)cc1] |
| C-14 | 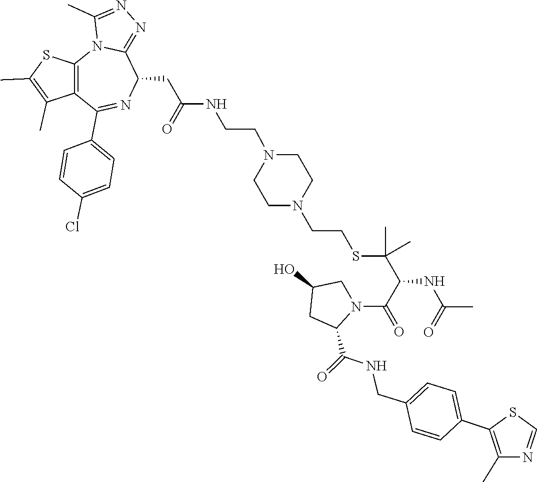 [SMILES: CC(=O)N[C@H](C(=O)N1C[C@H](O)C[C@H]1C(=O)NCc1ccc(-c2scnc2C)cc1)C(C)(C)SCCN1CCN(CCNC(=O)C[C@@H]2N=C(c3ccc(Cl)cc3)c3c(sc(C)c3C)-n3c(C)nnc32)CC1] |
| C-15 | 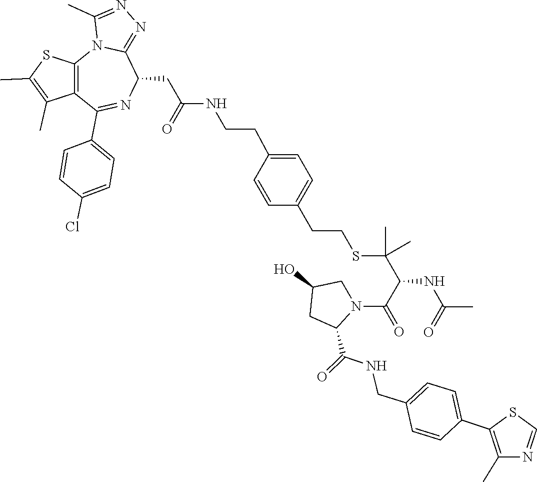 [SMILES: CC(=O)N[C@H](C(=O)N1C[C@H](O)C[C@H]1C(=O)NCc1ccc(-c2scnc2C)cc1)C(C)(C)SCCc1ccc(CCNC(=O)C[C@@H]2N=C(c3ccc(Cl)cc3)c3c(sc(C)c3C)-n3c(C)nnc32)cc1] |
| C-16 | 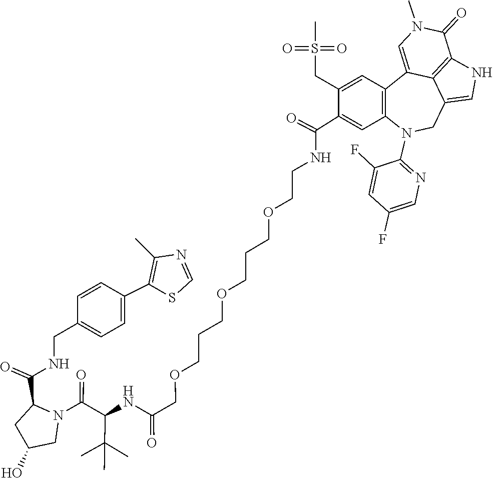 [SMILES: Cc1ncsc1-c1ccc(CNC(=O)[C@@H]2C[C@@H](O)CN2C(=O)[C@@H](NC(=O)COCCCOCCCOCCNC(=O)c2cc3c(cc2CS(C)(=O)=O)-c2cn(C)c(=O)c4[nH]cc(c24)CN3c2ncc(F)cc2F)C(C)(C)C)cc1] |
| C-17 | 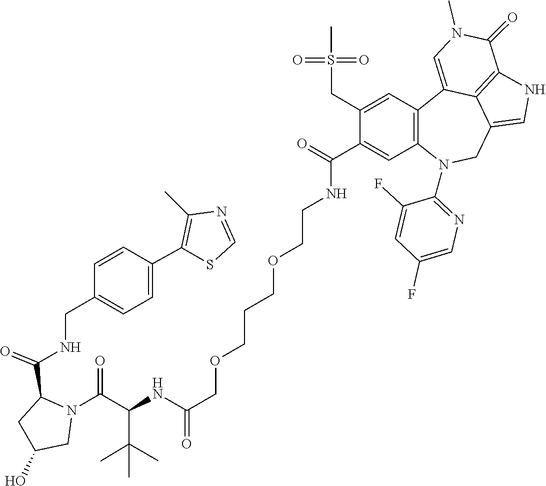 [SMILES: Cc1ncsc1-c1ccc(CNC(=O)[C@@H]2C[C@@H](O)CN2C(=O)[C@@H](NC(=O)COCCCOCCNC(=O)c2cc3c(cc2CS(C)(=O)=O)-c2cn(C)c(=O)c4[nH]cc(c24)CN3c2ncc(F)cc2F)C(C)(C)C)cc1] |
| C-18 | 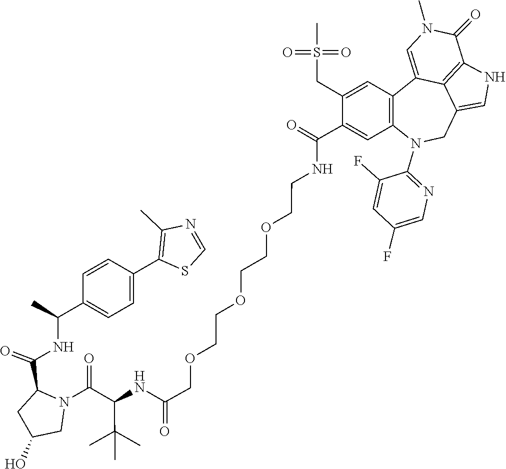 [SMILES: Cc1ncsc1-c1ccc([C@H](C)NC(=O)[C@@H]2C[C@@H](O)CN2C(=O)[C@@H](NC(=O)COCCOCCOCCNC(=O)c2cc3c(cc2CS(C)(=O)=O)-c2cn(C)c(=O)c4[nH]cc(c24)CN3c2ncc(F)cc2F)C(C)(C)C)cc1] |
| C-19 | 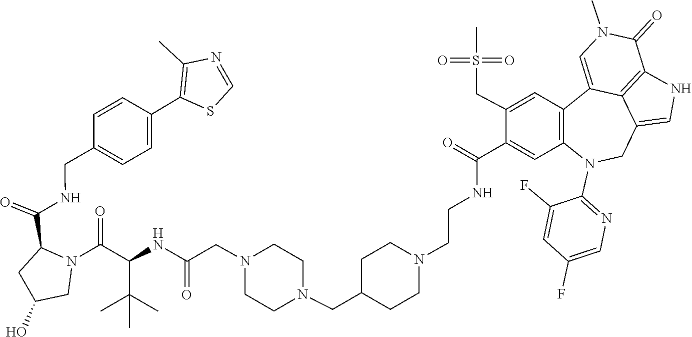 [SMILES: Cc1ncsc1-c1ccc(CNC(=O)[C@@H]2C[C@@H](O)CN2C(=O)[C@@H](NC(=O)CN2CCN(CC3CCN(CCNC(=O)c4cc5c(cc4CS(C)(=O)=O)-c4cn(C)c(=O)c6[nH]cc(c46)CN5c4ncc(F)cc4F)CC3)CC2)C(C)(C)C)cc1] |
| C-20 | 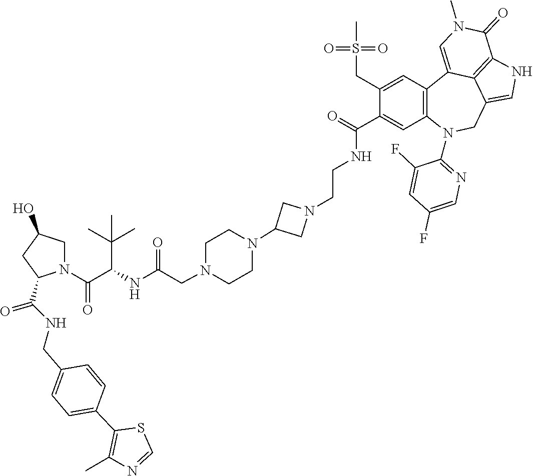 [SMILES: Cc1ncsc1-c1ccc(CNC(=O)[C@@H]2C[C@@H](O)CN2C(=O)[C@@H](NC(=O)CN2CCN(C3CN(CCNC(=O)c4cc5c(cc4CS(C)(=O)=O)-c4cn(C)c(=O)c6[nH]cc(c46)CN5c4ncc(F)cc4F)C3)CC2)C(C)(C)C)cc1] |
| C-21 | 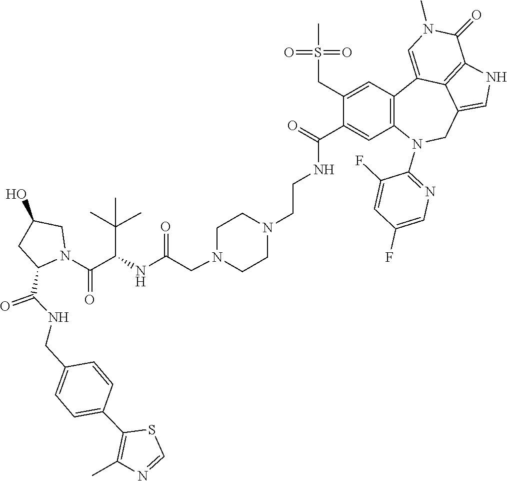 [SMILES: Cc1ncsc1-c1ccc(CNC(=O)[C@@H]2C[C@@H](O)CN2C(=O)[C@@H](NC(=O)CN2CCN(CCNC(=O)c3cc4c(cc3CS(C)(=O)=O)-c3cn(C)c(=O)c5[nH]cc(c35)CN4c3ncc(F)cc3F)CC2)C(C)(C)C)cc1] |
| C-22 | 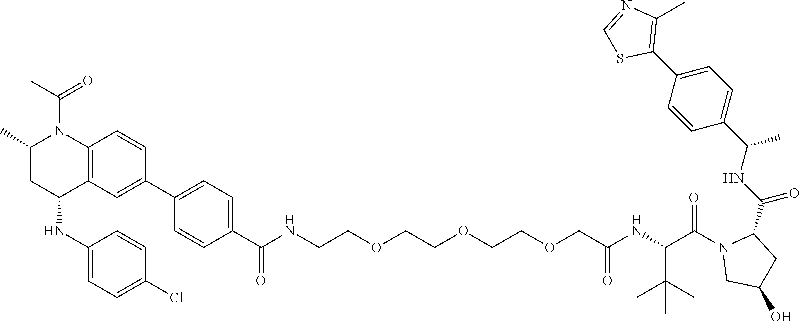 [SMILES: CC(=O)N1c2ccc(-c3ccc(C(=O)NCCOCCOCCOCC(=O)N[C@H](C(=O)N4C[C@H](O)C[C@H]4C(=O)N[C@@H](C)c4ccc(-c5scnc5C)cc4)C(C)(C)C)cc3)cc2[C@H](Nc2ccc(Cl)cc2)C[C@@H]1C] |
| C-23 | 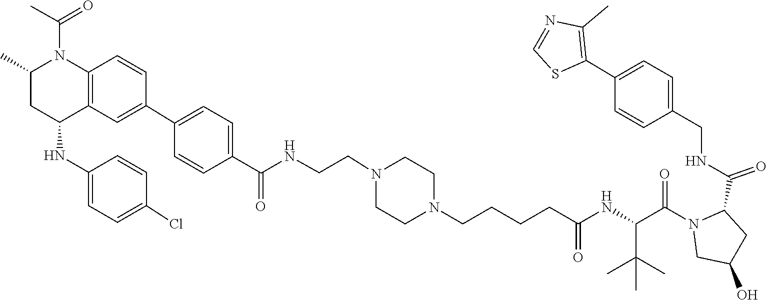 [SMILES: CC(=O)N1c2ccc(-c3ccc(C(=O)NCCN4CCN(CCCCC(=O)N[C@H](C(=O)N5C[C@H](O)C[C@H]5C(=O)NCc5ccc(-c6scnc6C)cc5)C(C)(C)C)CC4)cc3)cc2[C@H](Nc2ccc(Cl)cc2)C[C@@H]1C] |
| C-24 | 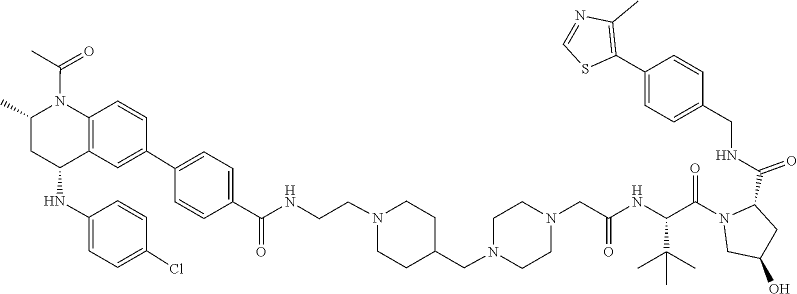 [SMILES: CC(=O)N1c2ccc(-c3ccc(C(=O)NCCN4CCC(CN5CCN(CC(=O)N[C@H](C(=O)N6C[C@H](O)C[C@H]6C(=O)NCc6ccc(-c7scnc7C)cc6)C(C)(C)C)CC5)CC4)cc3)cc2[C@H](Nc2ccc(Cl)cc2)C[C@@H]1C] |
| C-25 | 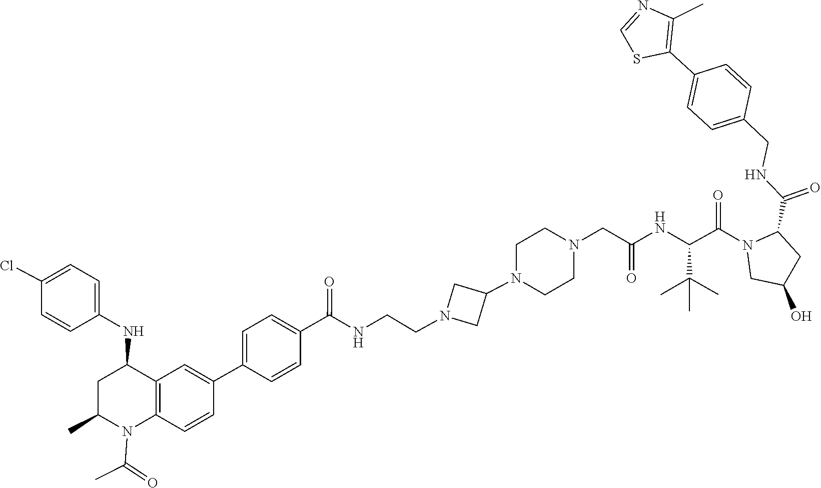 [SMILES: CC(=O)N1c2ccc(-c3ccc(C(=O)NCCN4CC(N5CCN(CC(=O)N[C@H](C(=O)N6C[C@H](O)C[C@H]6C(=O)NCc6ccc(-c7scnc7C)cc6)C(C)(C)C)CC5)C4)cc3)cc2[C@H](Nc2ccc(Cl)cc2)C[C@@H]1C] |
| C-26 | 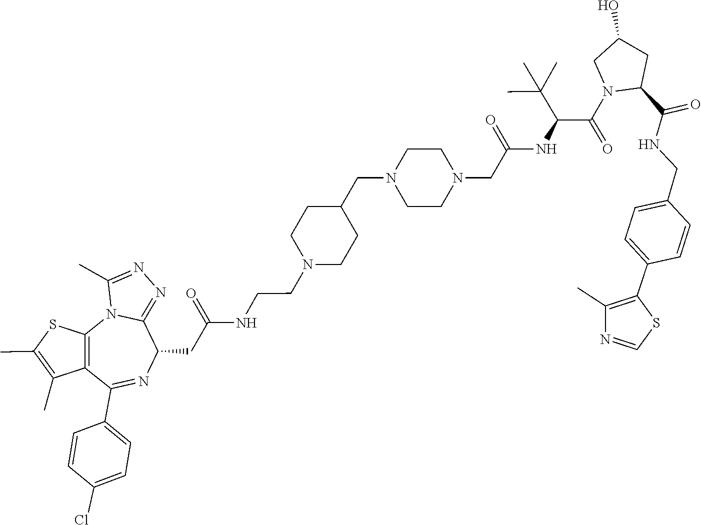 [SMILES: Cc1ncsc1-c1ccc(CNC(=O)[C@@H]2C[C@@H](O)CN2C(=O)[C@@H](NC(=O)CN2CCN(CC3CCN(CCNC(=O)C[C@@H]4N=C(c5ccc(Cl)cc5)c5c(sc(C)c5C)-n5c(C)nnc54)CC3)CC2)C(C)(C)C)cc1] |
| C-27 | 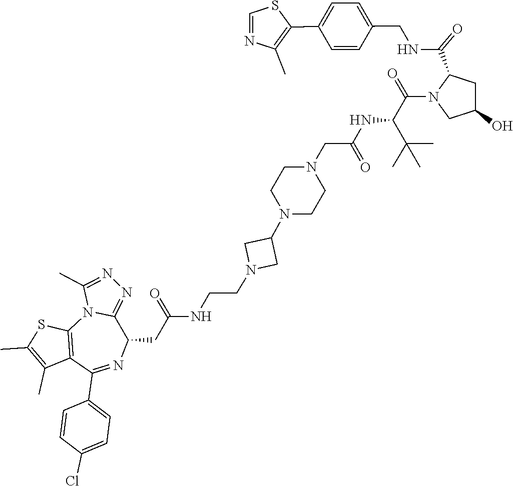 [SMILES: Cc1ncsc1-c1ccc(CNC(=O)[C@@H]2C[C@@H](O)CN2C(=O)[C@@H](NC(=O)CN2CCN(C3CN(CCNC(=O)C[C@@H]4N=C(c5ccc(Cl)cc5)c5c(sc(C)c5C)-n5c(C)nnc54)C3)CC2)C(C)(C)C)cc1] |
| C-28 | 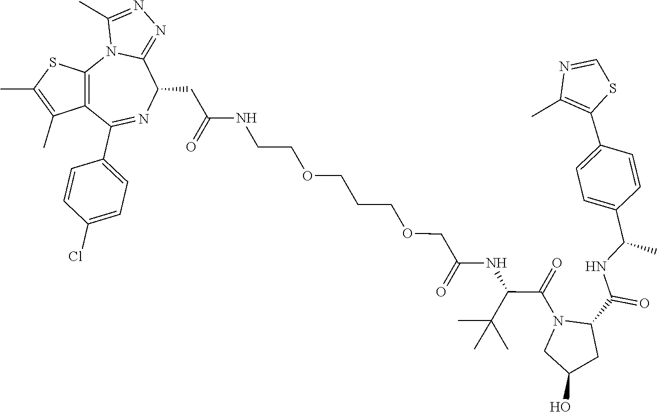 [SMILES: Cc1ncsc1-c1ccc([C@H](C)NC(=O)[C@@H]2C[C@@H](O)CN2C(=O)[C@@H](NC(=O)COCCCOCCNC(=O)C[C@@H]2N=C(c3ccc(Cl)cc3)c3c(sc(C)c3C)-n3c(C)nnc32)C(C)(C)C)cc1] |
| C-29 | 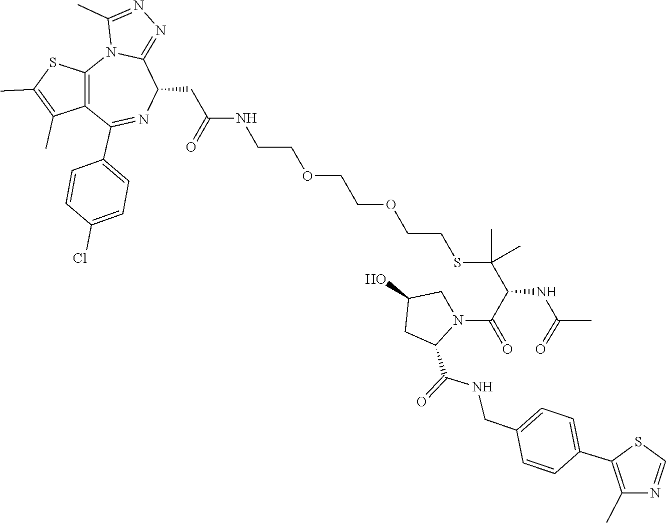 [SMILES: CC(=O)N[C@H](C(=O)N1C[C@H](O)C[C@H]1C(=O)NCc1ccc(-c2scnc2C)cc1)C(C)(C)SCCOCCOCCNC(=O)C[C@@H]1N=C(c2ccc(Cl)cc2)c2c(sc(C)c2C)-n2c(C)nnc21] |
| C-30 | 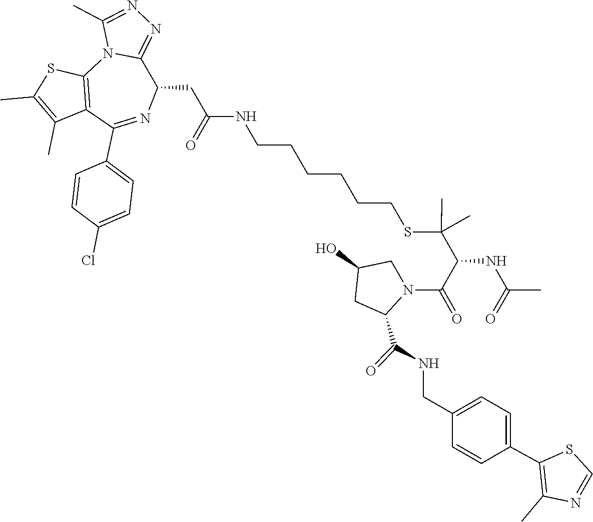 |
| C-31 | 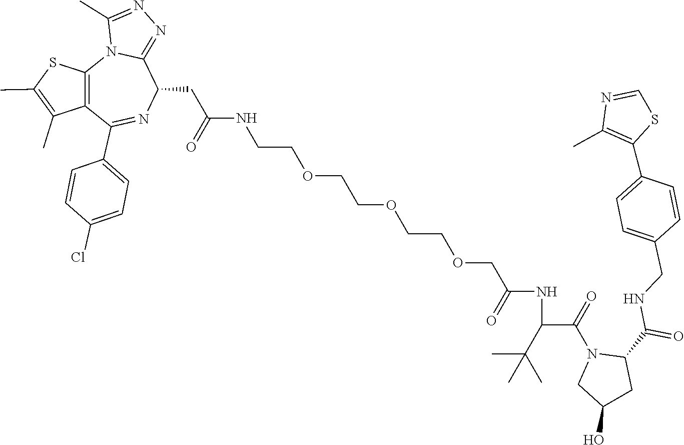 [SMILES: Cc1ncsc1-c1ccc(CNC(=O)[C@@H]2C[C@@H](O)CN2C(=O)C(NC(=O)COCCOCCOCCNC(=O)C[C@@H]2N=C(c3ccc(Cl)cc3)c3c(sc(C)c3C)-n3c(C)nnc32)C(C)(C)C)cc1] |
| C-32 | 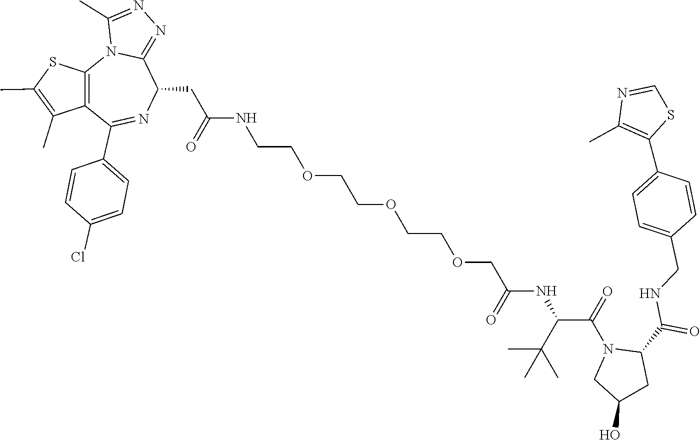 [SMILES: Cc1ncsc1-c1ccc(CNC(=O)[C@@H]2C[C@@H](O)CN2C(=O)[C@@H](NC(=O)COCCOCCOCCNC(=O)C[C@@H]2N=C(c3ccc(Cl)cc3)c3c(sc(C)c3C)-n3c(C)nnc32)C(C)(C)C)cc1] |
| C-33 | 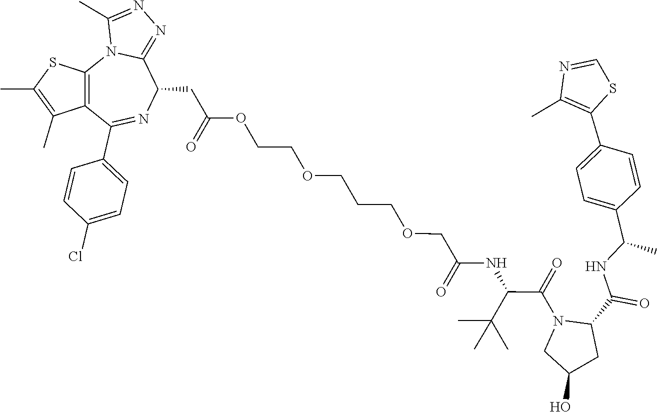 [SMILES: Cc1ncsc1-c1ccc([C@H](C)NC(=O)[C@@H]2C[C@@H](O)CN2C(=O)[C@@H](NC(=O)COCCCOCCOC(=O)C[C@@H]2N=C(c3ccc(Cl)cc3)c3c(sc(C)c3C)-n3c(C)nnc32)C(C)(C)C)cc1] |
| C-34 | 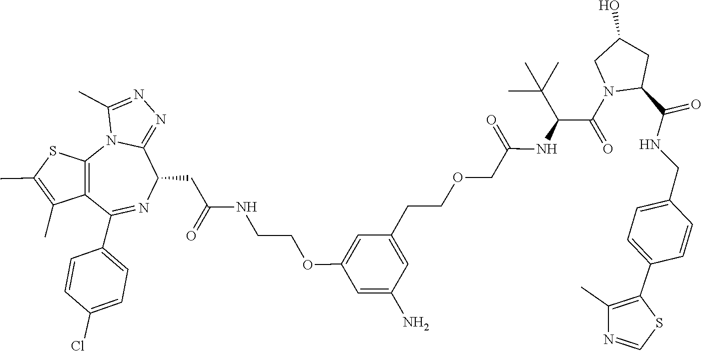 [SMILES: Cc1ncsc1-c1ccc(CNC(=O)[C@@H]2C[C@@H](O)CN2C(=O)[C@@H](NC(=O)COCCc2cc(N)cc(OCCNC(=O)C[C@@H]3N=C(c4ccc(Cl)cc4)c4c(sc(C)c4C)-n4c(C)nnc43)c2)C(C)(C)C)cc1] |
| C-35 | 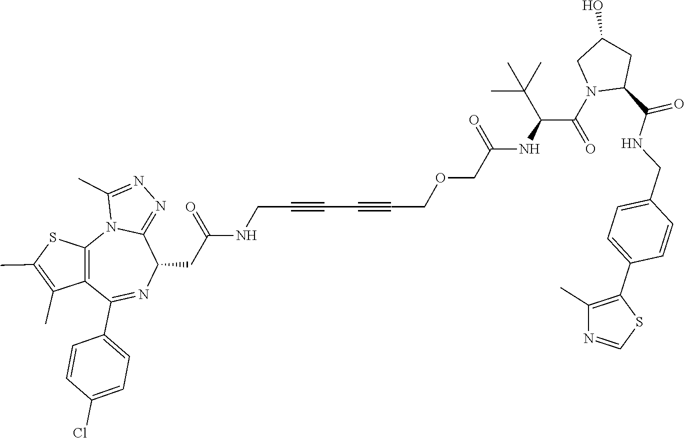 [SMILES: Cc1ncsc1-c1ccc(CNC(=O)[C@@H]2C[C@@H](O)CN2C(=O)[C@@H](NC(=O)COCC#CC#CCNC(=O)C[C@@H]2N=C(c3ccc(Cl)cc3)c3c(sc(C)c3C)-n3c(C)nnc32)C(C)(C)C)cc1] |
| C-36 | 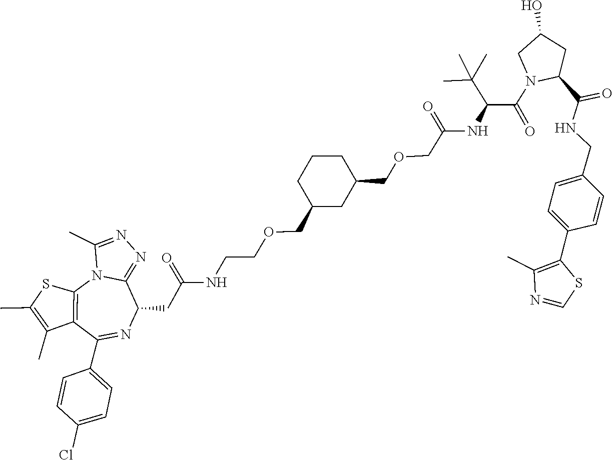 [SMILES: Cc1ncsc1-c1ccc(CNC(=O)[C@@H]2C[C@@H](O)CN2C(=O)[C@@H](NC(=O)COC[C@@H]2CCC[C@H](COCCNC(=O)C[C@@H]3N=C(c4ccc(Cl)cc4)c4c(sc(C)c4C)-n4c(C)nnc43)C2)C(C)(C)C)cc1] |
| C-37 | 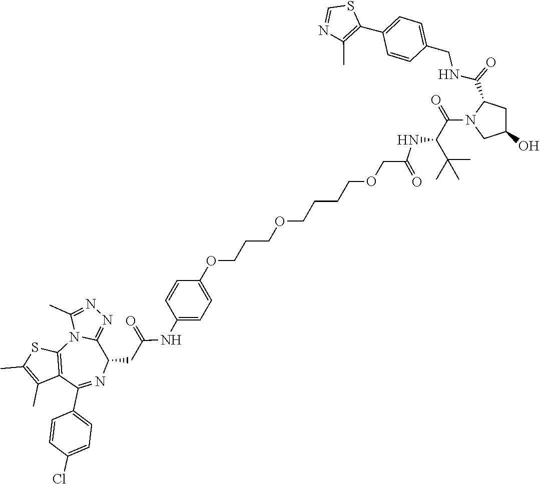 [SMILES: Cc1ncsc1-c1ccc(CNC(=O)[C@@H]2C[C@@H](O)CN2C(=O)[C@@H](NC(=O)COCCCCOCCCOc2ccc(NC(=O)C[C@@H]3N=C(c4ccc(Cl)cc4)c4c(sc(C)c4C)-n4c(C)nnc43)cc2)C(C)(C)C)cc1] |
| C-38 | 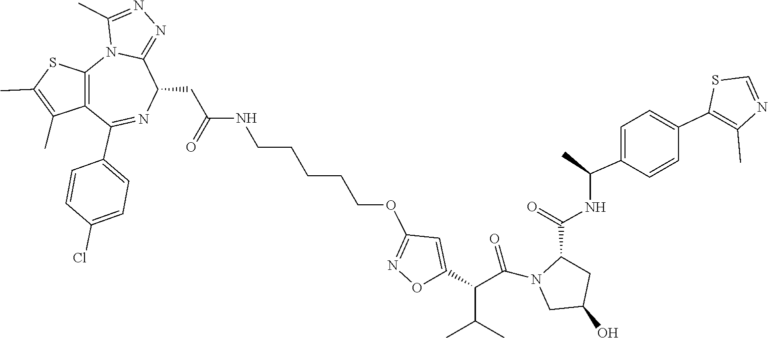 [SMILES: Cc1ncsc1-c1ccc([C@H](C)NC(=O)[C@@H]2C[C@@H](O)CN2C(=O)[C@@H](c2cc(OCCCCCNC(=O)C[C@@H]3N=C(c4ccc(Cl)cc4)c4c(sc(C)c4C)-n4c(C)nnc43)no2)C(C)C)cc1] |
| C-39 | 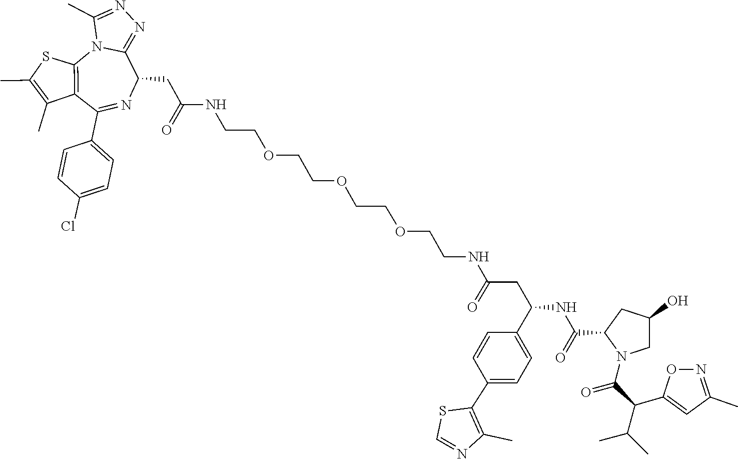 |
| C-40 | 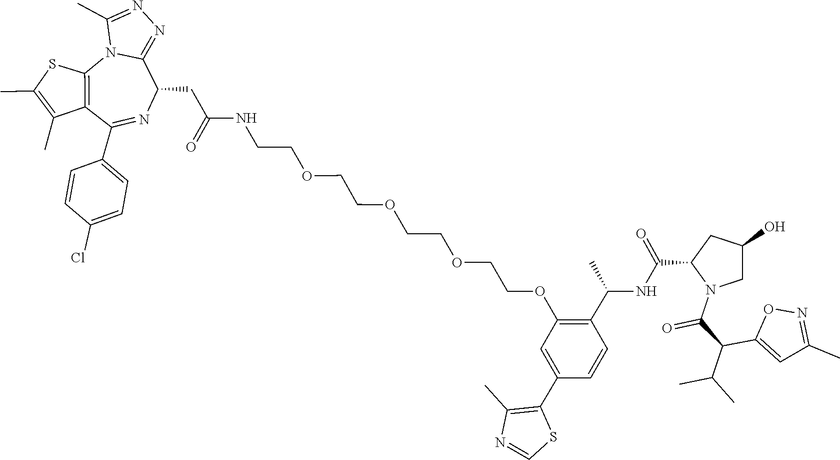 |
| C-41 | 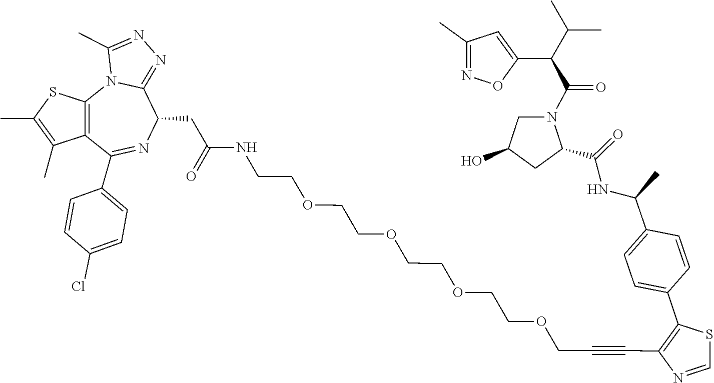 [SMILES: Cc1cc([C@H](C(=O)N2C[C@H](O)C[C@H]2C(=O)N[C@@H](C)c2ccc(-c3scnc3C#CCOCCOCCOCCOCCNC(=O)C[C@@H]3N=C(c4ccc(Cl)cc4)c4c(sc(C)c4C)-n4c(C)nnc43)cc2)C(C)C)on1] |
| C-42 | 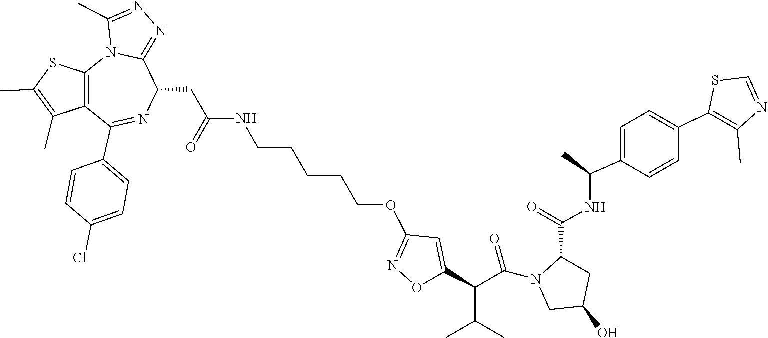 [SMILES: Cc1ncsc1-c1ccc([C@H](C)NC(=O)[C@@H]2C[C@@H](O)CN2C(=O)[C@H](c2cc(OCCCCCNC(=O)C[C@@H]3N=C(c4ccc(Cl)cc4)c4c(sc(C)c4C)-n4c(C)nnc43)no2)C(C)C)cc1] |
| C-43 | 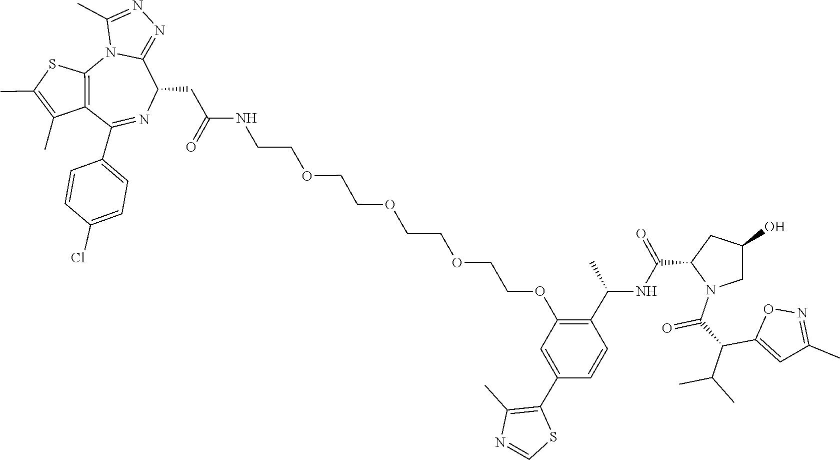 |
| C-44 | 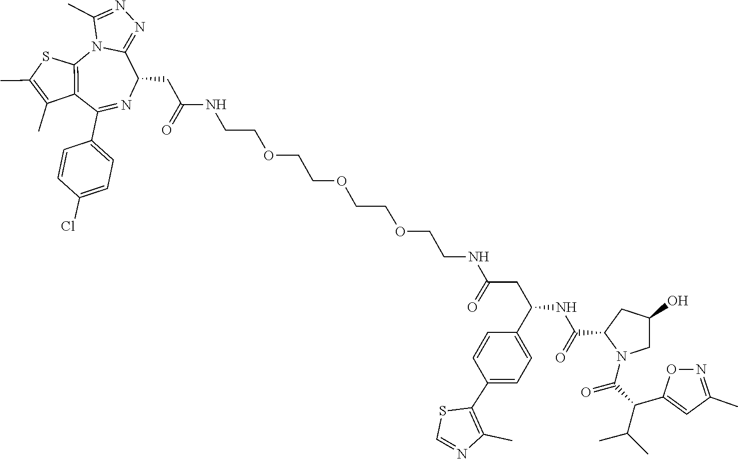 |
| C-45 | 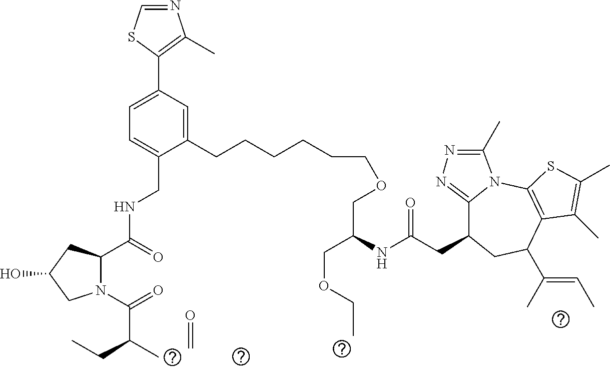 |
| C-46 | 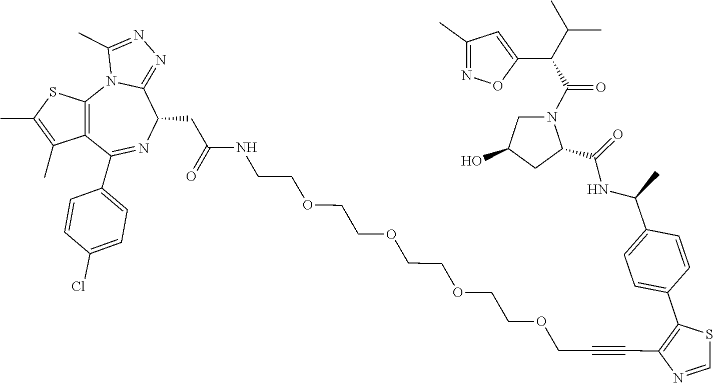 [SMILES: Cc1cc([C@@H](C(=O)N2C[C@H](O)C[C@H]2C(=O)N[C@@H](C)c2ccc(-c3scnc3C#CCOCCOCCOCCOCCNC(=O)C[C@@H]3N=C(c4ccc(Cl)cc4)c4c(sc(C)c4C)-n4c(C)nnc43)cc2)C(C)C)on1] |
| C-47 | 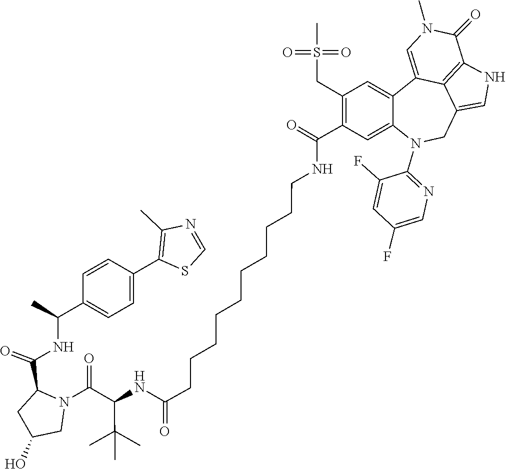 [SMILES: Cc1ncsc1-c1ccc([C@H](C)NC(=O)[C@@H]2C[C@@H](O)CN2C(=O)[C@@H](NC(=O)CCCCCCCCCCNC(=O)c2cc3c(cc2CS(C)(=O)=O)-c2cn(C)c(=O)c4[nH]cc(c24)CN3c2ncc(F)cc2F)C(C)(C)C)cc1] |
| C-48 | 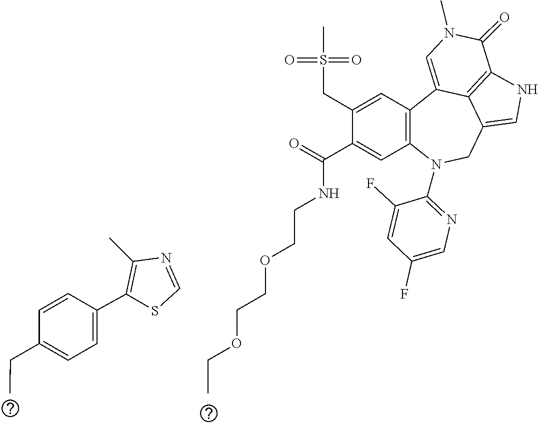 [SMILES: CCc1ccc(-c2scnc2C)cc1 ; CCOCCOCCNC(=O)c1cc2c(cc1CS(C)(=O)=O)-c1cn(C)c(=O)c3[nH]cc(c13)CN2c1ncc(F)cc1F] |
| C-49 | 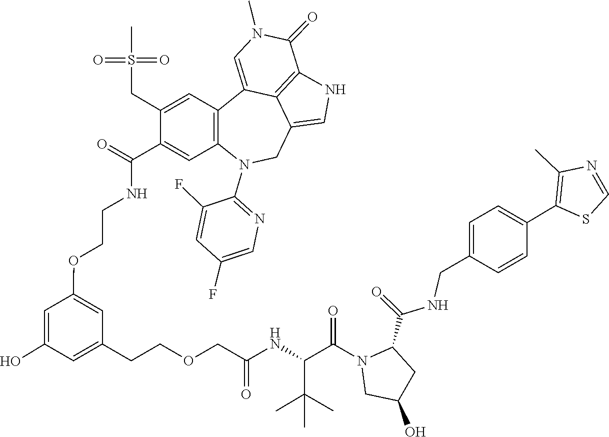 [SMILES: Cc1ncsc1-c1ccc(CNC(=O)[C@@H]2C[C@@H](O)CN2C(=O)[C@@H](NC(=O)COCCc2cc(O)cc(OCCNC(=O)c3cc4c(cc3CS(C)(=O)=O)-c3cn(C)c(=O)c5[nH]cc(c35)CN4c3ncc(F)cc3F)c2)C(C)(C)C)cc1] |
| C-50 | 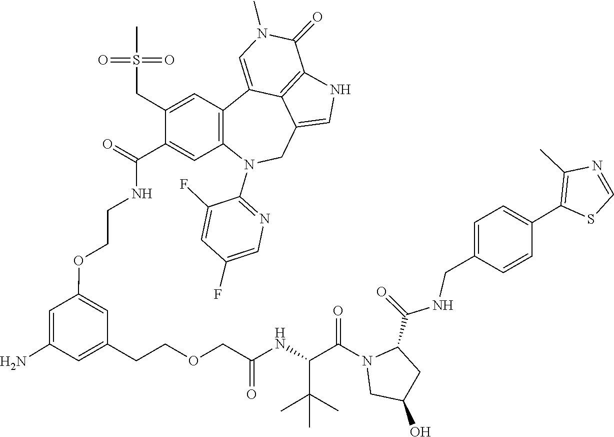 [SMILES: Cc1ncsc1-c1ccc(CNC(=O)[C@@H]2C[C@@H](O)CN2C(=O)[C@@H](NC(=O)COCCc2cc(N)cc(OCCNC(=O)c3cc4c(cc3CS(C)(=O)=O)-c3cn(C)c(=O)c5[nH]cc(c35)CN4c3ncc(F)cc3F)c2)C(C)(C)C)cc1] |
| C-51 | 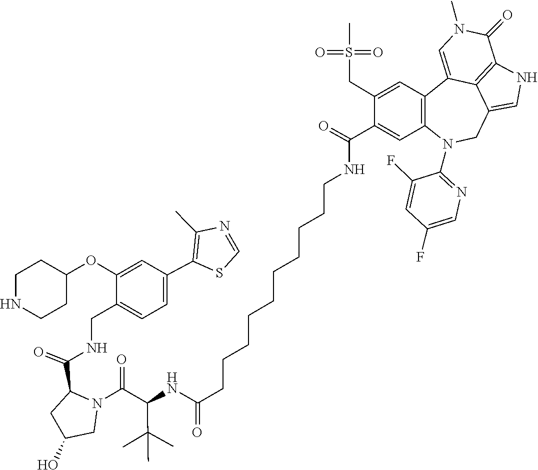 [SMILES: Cc1ncsc1-c1ccc(CNC(=O)[C@@H]2C[C@@H](O)CN2C(=O)[C@@H](NC(=O)CCCCCCCCCCNC(=O)c2cc3c(cc2CS(C)(=O)=O)-c2cn(C)c(=O)c4[nH]cc(c24)CN3c2ncc(F)cc2F)C(C)(C)C)c(OC2CCNCC2)c1] |
| C-52 | 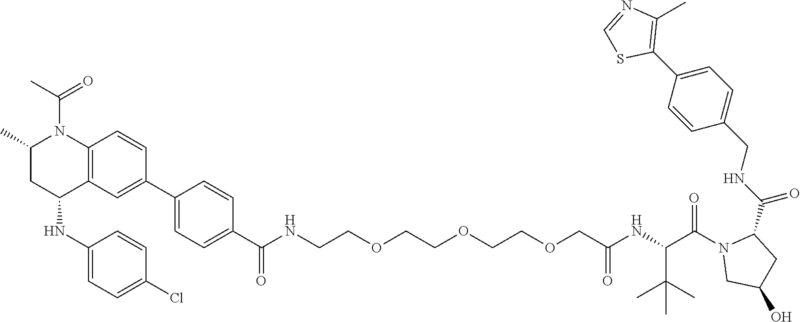 [SMILES: CC(=O)N1c2ccc(-c3ccc(C(=O)NCCOCCOCCOCC(=O)N[C@H](C(=O)N4C[C@H](O)C[C@H]4C(=O)NCc4ccc(-c5scnc5C)cc4)C(C)(C)C)cc3)cc2[C@H](Nc2ccc(Cl)cc2)C[C@@H]1C] |
| C-53 | 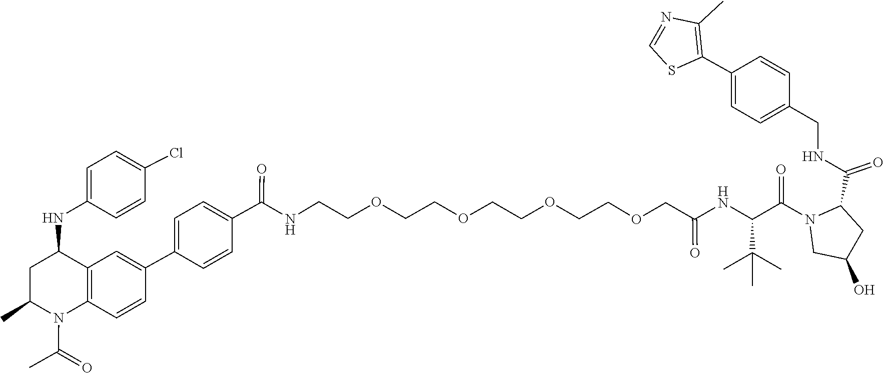 [SMILES: CC(=O)N1c2ccc(-c3ccc(C(=O)NCCOCCOCCOCCOCC(=O)N[C@H](C(=O)N4C[C@H](O)C[C@H]4C(=O)NCc4ccc(-c5scnc5C)cc4)C(C)(C)C)cc3)cc2[C@H](Nc2ccc(Cl)cc2)C[C@@H]1C] |
| C-54 | 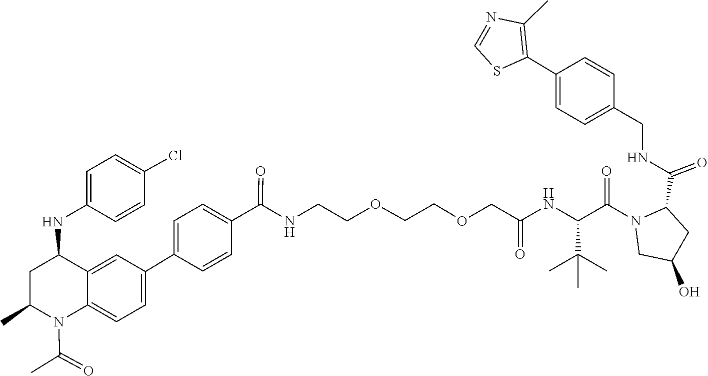 [SMILES: CC(=O)N1c2ccc(-c3ccc(C(=O)NCCOCCOCC(=O)N[C@H](C(=O)N4C[C@H](O)C[C@H]4C(=O)NCc4ccc(-c5scnc5C)cc4)C(C)(C)C)cc3)cc2[C@H](Nc2ccc(Cl)cc2)C[C@@H]1C] |
| C-55 | 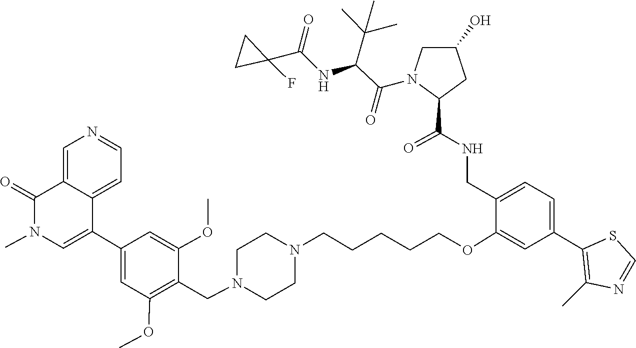 [SMILES: COc1cc(-c2cn(C)c(=O)c3cnccc23)cc(OC)c1CN1CCN(CCCCCOc2cc(-c3scnc3C)ccc2CNC(=O)[C@@H]2C[C@@H](O)CN2C(=O)[C@@H](NC(=O)C2(F)CC2)C(C)(C)C)CC1] |
| C-56 | 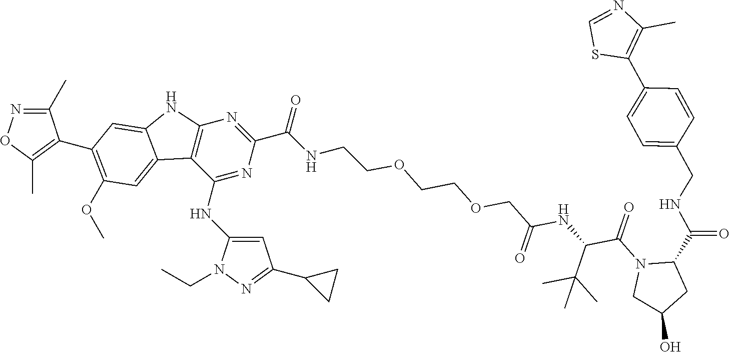 [SMILES: CCn1nc(C2CC2)cc1Nc1nc(C(=O)NCCOCCOCC(=O)N[C@H](C(=O)N2C[C@H](O)C[C@H]2C(=O)NCc2ccc(-c3scnc3C)cc2)C(C)(C)C)nc2[nH]c3cc(-c4c(C)noc4C)c(OC)cc3c12] |

### Example A-1. Synthesis of (2S,4R)-1-((S)-2-(tert-butyl)-14-(((5S,8S)-4-hydroxy-3-mesityl-2-oxo-1-oxaspiro[4.5]dec-3-en-8-yl)oxy)-4-Oxo-6,9,12-trioxa-3-azatetradecanoyl)-4-hydroxy-N—((S)-1-(4-(4-methylthiazol-5-yl)phenyl)ethyl)pyrrolidine-2-carboxamide

### A. Step 1

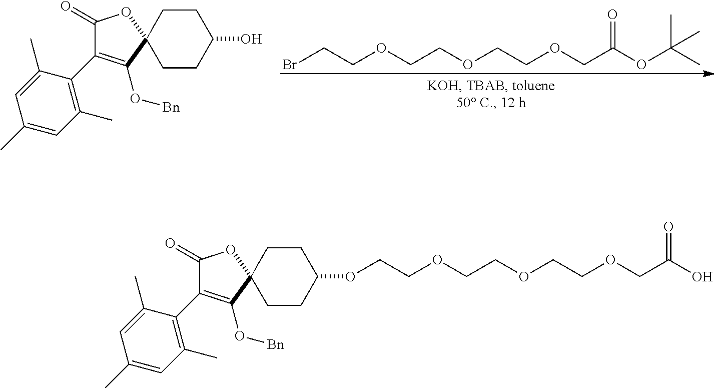 [SMILES: Cc1cc(C)c(C2=C(OCc3ccccc3)[C@]3(CC[C@H](O)CC3)OC2=O)c(C)c1 ; CC(C)(C)OC(=O)COCCOCCOCCBr ; Cc1cc(C)c(C2=C(OCc3ccccc3)[C@]3(CC[C@H](OCCOCCOCCOCC(=O)O)CC3)OC2=O)c(C)c1]

To a stirred mixture of (5S,8S)-4-(benzyloxy)-8-hydroxy-3-mesityl-1-oxaspiro[4.5]dec-3-en-2-one (200 mg, 509.57 μmol) (see Example 7, Step 10), tert-butyl 2-(2-(2-(2-bromoethoxy)ethoxy)ethoxy)acetate (250.11 mg, 764.36 μmol) and TBAB (65.71 mg, 203.83 μmol) in toluene (8 mL) was added KOH (142.95 mg, 2.55 mmol) at 25° C. The mixture was stirred at 50° C. for 12 hours. After cooling to 25° C., the mixture was acidified to pH=3 with 4N aqueous HCl. The mixture was diluted with EtOAc (8 mL) and H₂O (4 mL). The aqueous phase was extracted with EtOAc (5 mL×3). The organic layers were combined and washed with brine (5 mL×3), dried over Na₂SO₄, filtered, and concentrated in vacuo to give a residue. The residue was purified by prep-TLC (SiO₂, DCM/MeOH=10/1) to afford 2-(2-(2-(2-(((5S,8S)-4-(benzyloxy)-3-mesityl-2-oxo-1-oxaspiro[4.5]dec-3-en-8-yl)oxy)ethoxy)ethoxy)ethoxy)acetic acid (100 mg, 171.62 μmol, 33.68% yield) as a white solid. LCMS: RT=1.006 min, m/z 583.3 [M+H]⁺.

### B. Step 2

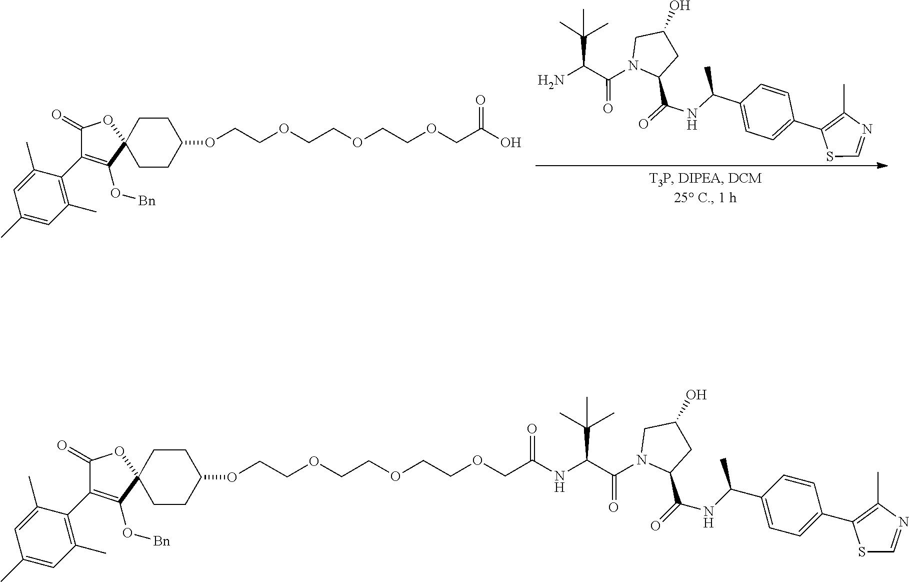

To a stirred solution of 2-(2-(2-(2-(((5s,8s)-4-(benzyloxy)-3-mesityl-2-oxo-1-oxaspiro[4.5]dec-3-en-8-yl)oxy)ethoxy)ethoxy)ethoxy)acetic acid (100 mg, 171.62 μmol) and (2S,4R)-1-[(2S)-2-amino-3,3-dimethyl-butanoyl]-4-hydroxy-N-[(1S)-1-[4-(4-methylthiazol-5-yl)phenyl]ethyl]pyrrolidine-2-carboxamide (123.84 mg, 257.43 μmol, HCl salt) in DCM (5 mL) were added DIPEA (88.72 mg, 686.48 μmol, 119.57 μL) and 50% T₃P (163.82 mg, 257.43 μmol, 153.10 μL) at 25° C. The reaction mixture was stirred at 25° C. for 1 hour. The reaction mixture was diluted with DCM (8 mL) and H₂O (5 mL). The aqueous phase was extracted with DCM (4 mL×3). The combined organic layers were washed with brine (10 mL×3), dried over Na₂SO₄, filtered, and concentrated in vacuo. The residue was re-dissolved in DCM (5 mL) and washed with 2N HCl aqueous solution (2 mL). The organic layer was concentrated to afford (2S,4R)-1-((S)-14-(((5s,8s)-4-(benzyloxy)-3-mesityl-2-oxo-1-oxaspiro[4.5]dec-3-en-8-yl)oxy)-2-(tert-butyl)-4-oxo-6,9,12-trioxa-3-azatetradecan-1-oyl)-4-hydroxy-N-((5)-1-(4-(4-methylthiazol-5-yl)phenyl)ethyl)pyrrolidine-2-carboxamide (150 mg, 119.49 μmol, 69.63% yield, 80.4% purity) as yellow oil, which was used to next step directly. LCMS: RT=0.980 min, m/z 505.4 [(M+H)/2]⁺.

### C. Step 3

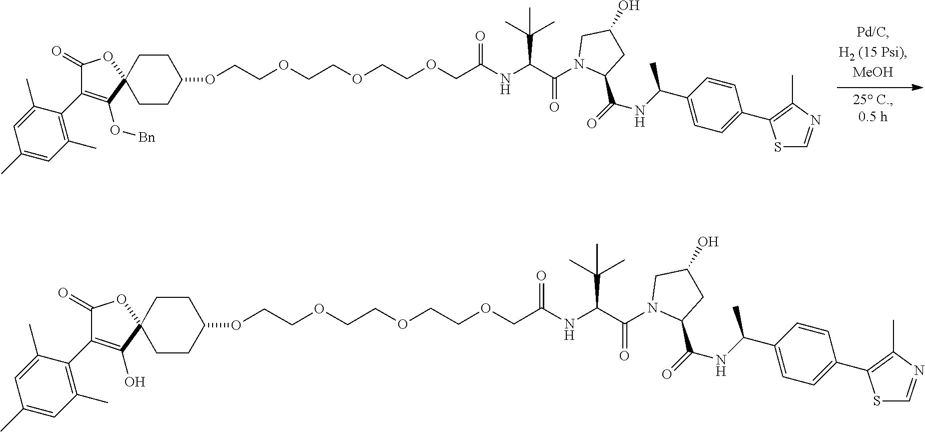 [SMILES: Cc1cc(C)c(C2=C(OCc3ccccc3)[C@]3(CC[C@H](OCCOCCOCCOCC(=O)N[C@H](C(=O)N4C[C@H](O)C[C@H]4C(=O)N[C@@H](C)c4ccc(-c5scnc5C)cc4)C(C)(C)C)CC3)OC2=O)c(C)c1 ; Cc1cc(C)c(C2=C(O)[C@]3(CC[C@H](OCCOCCOCCOCC(=O)N[C@H](C(=O)N4C[C@H](O)C[C@H]4C(=O)N[C@@H](C)c4ccc(-c5scnc5C)cc4)C(C)(C)C)CC3)OC2=O)c(C)c1]

To a solution of (2S,4R)-1-((S)-14-(((5s,8s)-4-(benzyloxy)-3-mesityl-2-oxo-1-oxaspiro[4.5]dec-3-en-8-yl)oxy)-2-(tert-butyl)-4-oxo-6,9,12-trioxa-3-azatetradecan-1-oyl)-4-hydroxy-N—((S)-1-(4-(4-methylthiazol-5-yl)phenyl)ethyl)pyrrolidine-2-carboxamide (140 mg, 111.53 μmol, 80.4% purity) in MeOH (8 mL) was added 10% Pd/C (70 mg) at 25° C. The reaction mixture was stirred at 25° C. for 0.5 hour under H₂ (15 psi). The mixture was filtered, and the filtrate concentrated in vacuo. The residue was purified by prep-HPLC twice (column: 3 Phenomenex Luna C18, 75×30 mm×3 μm, mobile phase: [water (0.1% TFA)-ACN], B %: 48-68, 7 min; column: Phenomenex Gemini-NX C18, 75×30 mm×3 μm, mobile phase: [water(10 mM NH₄HCO₃)-ACN], B %: 1535, 8 min) to afford (2S,4R)-1-((S)-2-(tert-butyl)-14-(((5s,8s)-4-hydroxy-3-mesityl-2-oxo-1-oxaspiro[4.5]dec-3-en-8-yl)oxy)-4-oxo-6,9,12-trioxa-3-azatetradecan-1-oyl)-4-hydroxy-N—((S)-1-(4-(4-methylthiazol-5-yl)phenyl)ethyl)pyrrolidine-2-carboxamide (14.74 mg, 15.68 μmol, 14.06% yield, 97.8% purity) as a white solid. HNMR: CDCl₃, 400 MHz. δ 8.41 (s, 1H), 7.55-7.43 (m, 1H), 7.37-7.30 (m, 5H), 6.81 (d, J=7.2 Hz, 2H), 5.04 (t, J=6.8 Hz, 1H), 4.62 (t, J=8.0 Hz, 1H), 4.53 (d, J=8.8 Hz, 1H), 4.40-4.33 (m, 1H), 4.07-3.95 (m, 3H), 3.68-3.59 (m, 13H), 3.42-3.35 (m, 1H), 2.48 (s, 3H), 2.26-2.18 (m, 4H), 2.12 (d, J=2.4 Hz, 6H), 2.06-1.96 (m, 5H), 1.75-1.66 (m, 4H), 1.43 (d, J=6.8 Hz, 3H), 1.04 (s, 9H). LCMS: RT=2.758 min, m/z 460.2 [(M+H)/2]⁺.

### Example A-2. Synthesis of (2S,4R)-1-((S)-2-(tert-butyl)-14-(((5R,8R)-4-hydroxy-3-mesityl-2-oxo-1-oxaspiro[4.5]dec-3-en-8-yl)oxy)-4-oxo-6,9,12-trioxa-3-azatetradecanoyl)-4-hydroxy-N—((S)-1-(4-(4-methylthiazol-5-yl)phenyl)ethyl)pyrrolidine-2-carboxamide

### A. Step 1

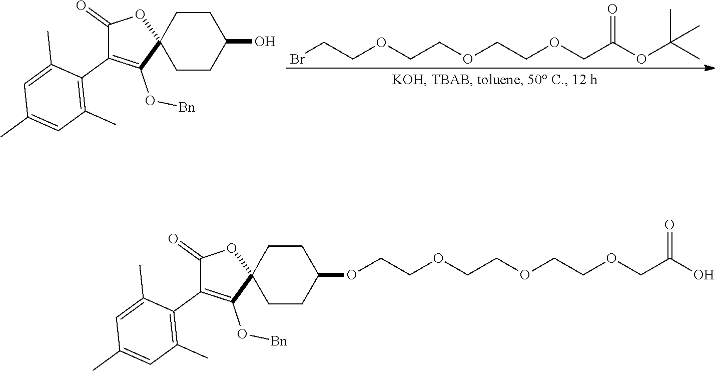

To a mixture of (5r,8r)-4-(benzyloxy)-8-hydroxy-3-mesityl-1-oxaspiro[4.5]dec-3-en-2-one (200 mg, 509.57 μmol; prepared using general methods described herein for the preparation of (5s,8s)-4-(benzyloxy)-8-hydroxy-3-mesityl-1-oxaspiro[4.5]dec-3-en-2-one) and tert-butyl 2-[2-[2-(2-bromoethoxy)ethoxy]-ethoxy]acetate (333.48 mg, 1.02 mmol) in toluene (4 mL) were added KOH (142.96 mg, 2.55 mmol) and TBAB (82.14 mg, 254.79 μmol). The mixture was stirred at 50° C. for 12 hours. The pH of the reaction mixture was adjusted to 5-6 by addition of 2 M aqueous HCl and the resulting mixture extracted with EtOAc (20 mL×3). The combined organic layers were washed with brine (20 mL), dried over anhydrous Na₂SO₄, filtered, and concentrated under reduced pressure to give a residue. The residue was purified by prep-TLC (SiO₂, 10:1 DCM:MeOH) to give 2-(2-(2-(2-(((5r,8r)-4-(benzyloxy)-3-mesityl-2-oxo-1-oxaspiro[4.5]dec-3-en-8-yl)oxy)ethoxy)ethoxy)ethoxy)acetic acid (30 mg, 51.49 μmol, 10.10% yield) as a light-yellow oil. LCMS: RT=0.818 min, m/z 583.3 [M+H]⁺.

### B. Step 2

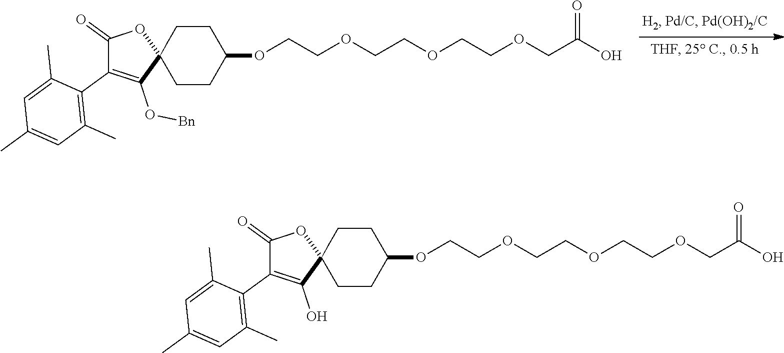 [SMILES: Cc1cc(C)c(C2=C(OCc3ccccc3)[C@]3(CC[C@@H](OCCOCCOCCOCC(=O)O)CC3)OC2=O)c(C)c1 ; Cc1cc(C)c(C2=C(O)[C@]3(CC[C@@H](OCCOCCOCCOCC(=O)O)CC3)OC2=O)c(C)c1]

To a mixture of 2-(2-(2-(2-(((5r,8r)-4-(benzyloxy)-3-mesityl-2-oxo-1-oxaspiro[4.5]dec-3-en-8-yl)oxy)ethoxy)ethoxy)ethoxy)acetic acid (30 mg, 51.49 μmol) in THF (5 mL) were added 10% Pd/C (5 mg) and 20% Pd(OH)₂/C (5 mg) under N₂. The mixture was degassed, purged with H₂ (3×), and stirred at 25° C. under H₂ (15 psi, balloon) for 0.5 hours. The mixture was filtered and the filtrate concentrated at reduced pressure to give 2-(2-(2-(2-(((5r,8r)-4-hydroxy-3-mesityl-2-oxo-1-oxaspiro[4.5]dec-3-en-8-yl)oxy)ethoxy)ethoxy)ethoxy)acetic acid (20 mg, crude) as a colorless oil, which was used in the next step without further purification. LCMS: RT=0.873 min, m/z 493.3 [M+H]⁺.

### C. Step 3

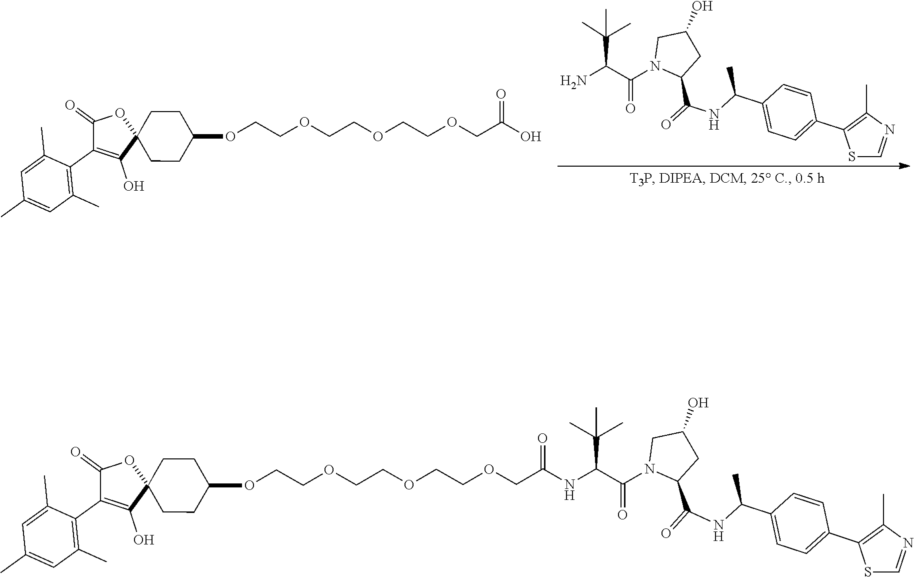

To a mixture of (2S,4R)-1-[(2S)-2-amino-3,3-dimethyl-butanoyl]-4-hydroxy-N-[(1S)-1-[4-(4-methylthiazol-5-yl)phenyl]ethyl]pyrrolidine-2-carboxamide (23.44 mg, 48.73 μmol, HCl salt) and 2-(2-(2-(2-(((5r,8r)-4-hydroxy-3-mesityl-2-oxo-1-oxaspiro[4.5]dec-3-en-8-yl)oxy)ethoxy)ethoxy)ethoxy)acetic acid (20 mg, 40.60 μmol) in DCM (1 mL) were added 50% T₃P (38.76 mg, 60.91 μmol, 36.22 μL) and DIPEA (20.99 mg, 162.42 μmol, 28.29 μL). The mixture was stirred at 25° C. for 0.5 hour. The mixture was diluted with H₂O (20 mL) and extracted with EtOAc (20 mL×3). The combined organic layers were washed with brine (20 mL×3), dried over anhydrous Na₂SO₄, and concentrated to dryness at reduced pressure. The residue was purified by prep-HPLC (column: Phenomenex Synergi C18, 150×25 mm×10 μm, mobile phase: [water (0.225% FA)-ACN], B %: 48-78, 10 min) to give (2S,4R)-1-((S)-2-(tert-butyl)-14-(((5r,8r)-4-hydroxy-3-mesityl-2-oxo-1-oxaspiro[4.5]dec-3-en-8-yl)oxy)-4-oxo-6,9,12-tr oxa-3-azatetradecanoyl)-4-hydroxy-N—((S)-1-(4-(4-methylthiazol-5-yl)phenyl)ethyl)pyrrolidine-2-carboxamide (10.73 mg, 11.55 μmol, 28.43% yield, 98.9% purity) as a brown gum. HNMR: DMSO-d₆, 400 MHz. δ 8.98 (s, 1H), 8.50-8.46 (m, 1H), 7.45-7.33 (m, 5H), 6.90-6.67 (m, 2H), 5.22-5.13 (m, 1H), 4.89 (t, J=7.2 Hz, 1H), 4.54 (d, J=9.6 Hz, 1H), 4.44 (t, J=8.0 Hz, 1H), 4.29-4.21 (m, 1H), 3.96 (s, 2H), 3.63-3.51 (m, 15H), 2.45 (s, 3H), 2.21 (s, 3H), 2.11-2.00 (m, 9H), 1.91-1.82 (m, 2H), 1.79-1.62 (m, 3H), 1.40-1.22 (m, 5H), 0.95-0.91 (m, 9H). LCMS: RT=2.565 min, m/z 919.4 [M+H]⁺.

### Example A-3. Synthesis of (2S,4R)-1-((S)-2-(tert-butyl)-17-(((5S,8S)-4-hydroxy-3-mesityl-2-oxo-1-oxaspiro[4.5]dec-3-en-8-yl)oxy)-4-oxo-6,9,12,15-tetraoxa-3-azaheptadecanoyl)-4-hydroxy-N—((S)-1-(4-(4-methylthiazol-5-yl)phenyl)ethyl)pyrrolidine-2-carboxamide

### A. Step 1

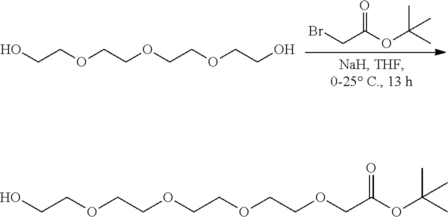

To a mixture of 2-[2-[2-(2-hydroxyethoxy)ethoxy]ethoxy]ethanol (39.83 g, 205.07 mmol, 35.25 mL) in THF (300 mL) was added 60% NaH (4.51 g, 112.79 mmol) at 0° C. under N₂. The resulting mixture was stirred at 0° C. for 1 hour. The mixture was treated with tert-butyl 2-bromoacetate (20 g, 102.54 mmol, 15.15 mL) and stirred at 25° C. for 12 hours. The mixture was added to H₂O (500 mL) and extracted with EtOAc (500 mL×68×). The organic phase was washed with brine (500 mL×2), dried over anhydrous Na₂SO₄, filtered, and concentrated under reduced pressure. The residue was purified by column chromatography (SiO₂, petroleum ether:EtOAc, 3:1 to 1:1 to 0:1) to afford tert-butyl 2-[2-[2-[2-(2-hydroxyethoxy)-ethoxy]ethoxy]ethoxy]acetate (7.79 g, 25.26 mmol, 24.64% yield) as a colorless oil. HNMR: CDCl₃, 400 MHz. δ 4.02 (s, 2H), 3.74-3.68 (m, 6H), 3.68-3.64 (m, 8H), 3.62-3.59 (m, 2H), 1.50-1.42 (m, 9H).

### B. Step 2

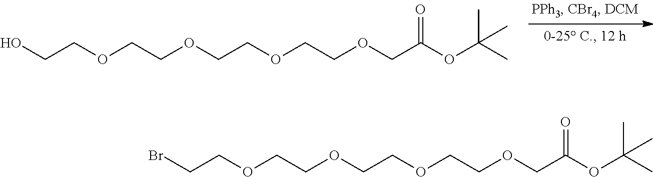 [SMILES: CC(C)(C)OC(=O)COCCOCCOCCOCCO ; CC(C)(C)OC(=O)COCCOCCOCCOCCBr]

To a mixture of tert-butyl 2-[2-[2-[2-(2-hydroxyethoxy)ethoxy]ethoxy]ethoxy]acetate (7.79 g, 25.26 mmol) in DCM (100 mL) were added CBr₄ (16.76 g, 50.52 mmol) and PPh₃ (13.25 g, 50.52 mmol) at 0° C. The mixture was stirred at 25° C. for 12 hours. The mixture was concentrated under reduced pressure to give a residue. The residue was purified by column chromatography (SiO₂, petroleum ether:EtOAc, 3:1 to 1:1) to afford tert-butyl 2-[2-[2-[2-(2-bromoethoxy)ethoxy]ethoxy]ethoxy]acetate (3.65 g, 9.83 mmol, 38.92% yield) as a colorless oil. HNMR: CDCl₃, 400 MHz. δ 4.03 (s, 2H), 3.82 (t, J=6.4 Hz, 2H), 3.75-3.64 (m, 12H), 3.49 (t, J=6.4 Hz, 2H), 1.52-1.42 (m, 9H).

### C. Step 3

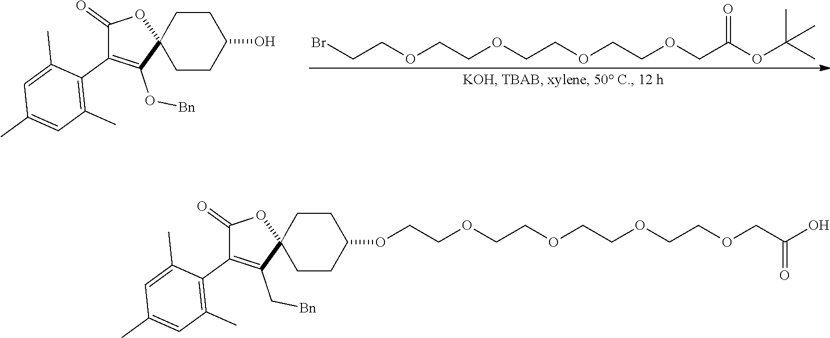

To a mixture of (5s,8s)-4-(benzyloxy)-8-hydroxy-3-mesityl-1-oxaspiro[4.5]dec-3-en-2-one (200 mg, 509.57 μmol; see Example 7, Step 10) and tert-butyl 2-[2-[2-[2-(2-bromoethoxy)ethoxy]ethoxy]ethoxy]acetate (283.78 mg, 764.36 μmol) in xylene (4 mL) were added KOH (142.96 mg, 2.55 mmol) and TBAB (82.14 mg, 254.79 μmol). The mixture was stirred at 50° C. for 12 hours. The pH of the reaction mixture was adjusted to 3-4 by addition of 2 M aqueous HCl aqueous. EtOAc (20 mL) and H₂O (20 mL) were added and layers were separated. The aqueous phase was extracted with EtOAc (20 mL×3). The combined organic layers were washed with brine (20 mL), dried over anhydrous Na₂SO₄, filtered, and concentrated to dryness at reduced pressure. The residue was purified by prep-TLC (SiO₂, 10:1 DCM:MeOH) to give 14-(((5s,8s)-4-(benzyloxy)-3-mesityl-2-oxo-1-oxaspiro[4.5]dec-3-en-8-yl)oxy)-3,6,9,12-tetraoxatetradecanoic acid (90 mg, 143.60 μmol, 28.18% yield) as a colorless gum. LCMS: RT=0.891 min, m/z 627.2 [M-55]⁺.

### D. Step 4

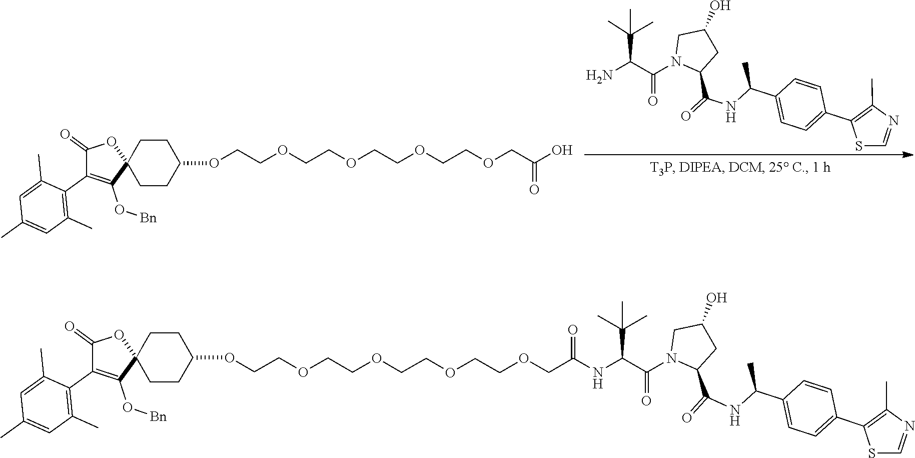

To a mixture of (2S,4R)-1-[(2S)-2-amino-3,3-dimethyl-butanoyl]-4-hydroxy-N-[(1S)-1-[4-(4-methylthiazol-5-yl)phenyl]ethyl]pyrrolidine-2-carboxamide (103.62 mg, 215.40 μmol, HCl salt) and 14-(((5s,8s)-4-(benzyloxy)-3-mesityl-2-oxo-1-oxaspiro[4.5]dec-3-en-8-yl)oxy)-3,6,9,12-tetraoxatetradecanoic acid (90 mg, 143.60 μmol) in DCM (4 mL) were added 50% T₃P (137.07 mg, 215.40 μmol, 128.11 μL) and DIPEA (74.24 mg, 574.41 μmol, 100.05 μL). The mixture was stirred at 25° C. for 1 hour. The mixture was concentrated to dryness at reduced pressure and the residue purified by flash chromatography (silica gel, gradient elution from 0 to 10% MeOH in DCM) to give (2S,4R)-1-((S)-17-(((5s,8s)-4-(benzyloxy)-3-mesityl-2-oxo-1-oxaspiro[4.5]dec-3-en-8-yl)oxy)-2-(tert-butyl)-4-oxo-6,9,12,15-tetraoxa-3-azaheptadecanoyl)-4-hydroxy-N—((S)-1-(4-(4-methylthiazol-5-yl)phenyl)ethyl)pyrrolidine-2-carboxamide (130 mg, 123.42 μmol, 85.95% yield) as a yellow gum. LCMS: RT=1.072 min, m/z 1054.2 [M+H]⁺.

### E. Step 5

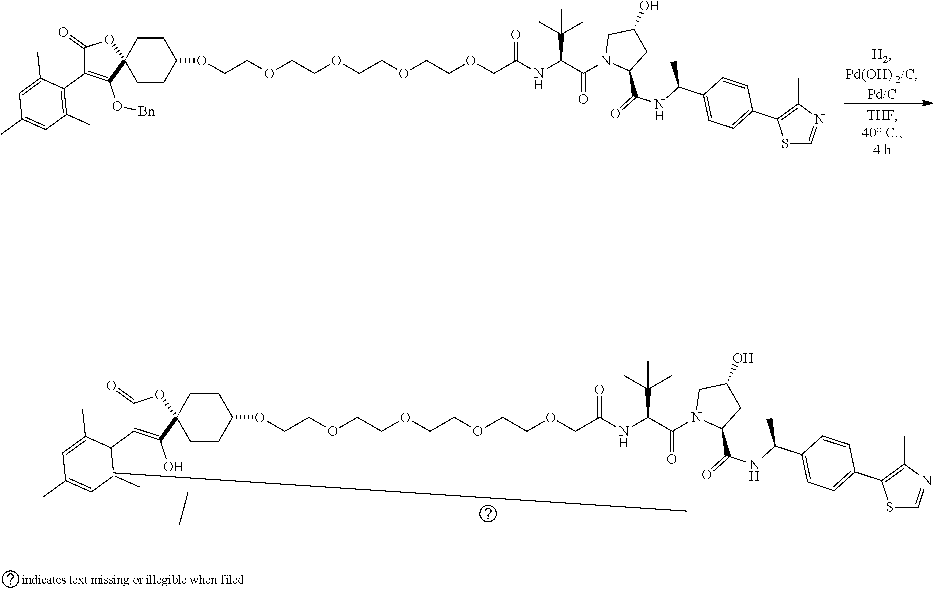

To a mixture of (2S,4R)-1-((S)-17-(((5s,8s)-4-(benzyloxy)-3-mesityl-2-oxo-1-oxaspiro[4.5]dec-3-en-8-yl)oxy)-2-(tert-butyl)-4-oxo-6,9,12,15-tetraoxa-3-azaheptadecanoyl)-4-hydroxy-N—((S)-1-(4-(4-methylthiazol-5-yl)phenyl)ethyl)pyrrolidine-2-carboxamide (130 mg, 123.42 μmol) in THE (20 mL) were added 10% Pd/C (30 mg) and 20% Pd(OH)₂/C (30 mg) under N₂. The mixture was degassed, purged with H₂ (3×), then stirred at 40° C. under 15 psi H₂ (balloon) for 4 hours. The mixture was filtered and the filtrate concentrated to dryness at reduced pressure. The residue was purified by prep-HPLC (column: Phenomenex Luna C18, 150×25 mm×10 μm, mobile phase: [water(0.225% FA)-ACN], B %: 44-74, 10 min) to give (2S,4R)-1-((S)-2-(tert-butyl)-17-(((5s,8s)-4-hydroxy-3-mesityl-2-oxo-1-oxaspiro[4.5]dec-3-en-8-yl)oxy)-4-oxo-6,9,12,15-tetraoxa-3-azaheptadecanoyl)-4-hydroxy-N—((S)-1-(4-(4-methylthiazol-5-yl)phenyl)ethyl)pyrrolidine-2-carboxamide (17.2 mg, 17.04 μmol, 13.81% yield, 95.42% purity) as a white solid. HNMR: DMSO-d₆, 400 MHz. δ 8.98 (s, 1H), 8.46-8.40 (m, 1H), 7.47-7.31 (m, 5H), 6.82 (s, 2H), 5.20-5.09 (m, 1H), 4.95-4.86 (m, 1H), 4.59-4.51 (m, 1H), 4.49-4.40 (m, 1H), 4.32-4.21 (m, 1H), 4.01-3.89 (m, 2H), 3.64-3.50 (m, 19H), 2.45 (s, 3H), 2.22 (s, 3H), 2.07-1.96 (m, 9H), 1.93-1.83 (m, 2H), 1.82-1.72 (m, 1H), 1.62-1.54 (m, 2H), 1.50-1.42 (m, 2H), 1.40-1.31 (m, 3H), 0.97-0.90 (m, 9H). LCMS: RT=2.522 min, m/z 963.4 [M+H]⁺.

### Example A-4. Synthesis of (2S,4R)-1-((S)-2-(tert-butyl)-17-(((5R,8R)-4-hydroxy-3-mesityl-2-oxo-1-oxaspiro[4.5]dec-3-en-8-yl)oxy)-4-oxo-6,9,12,15-tetraoxa-3-azaheptadecanoyl)-4-hydroxy-N—((S)-1-(4-(4-methylthiazol-5-yl)phenyl)ethyl)pyrrolidine-2-carboxamide

### A. Step 1

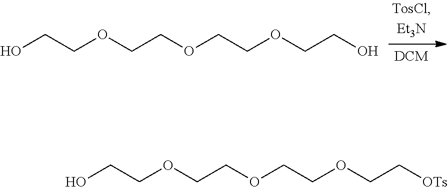 [SMILES: OCCOCCOCCOCCO ; Cc1ccc(S(=O)(=O)OCCOCCOCCOCCO)cc1]

To a solution of 2-[2-[2-(2-hydroxyethoxy)ethoxy]ethoxy]ethanol (50.94 g, 262.26 mmol, 45.08 mL) in DCM (50 mL) was added TsCl (5 g, 26.23 mmol) and Et3N (3.98 g, 39.34 mmol, 5.48 mL) at 0° C. The resulting mixture was stirred at 25° C. for 16 hours. The reaction mixture was washed with H₂O (60 mL), 1M aqueous HCl (60 mL×2), sat. NaHCO₃ (60 mL) and brine (60 mL), respectively. The organic phase was dried over Na₂SO₄, filtered and concentrated in vacuo to afford 2-[2-[2-(2-hydroxyethoxy)-ethoxy]ethoxy]ethyl 4-methylbenzenesulfonate (6 g, 17.22 mmol, 65.66% yield) as a colorless oil. H NMR: CDCl₃, 400 MHz. δ 7.80 (d, J=8.4 Hz, 2H), 7.35 (d, J=8.0 Hz, 2H), 4.21-4.13 (m, 2H), 3.74-3.58 (m, 14H), 2.65-2.56 (m, 1H), 2.45 (s, 3H).

### B. Step 2

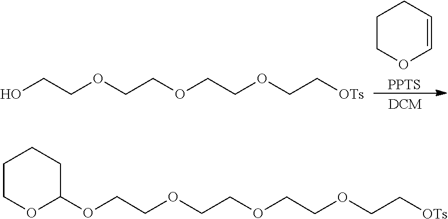

To a solution of 2-[2-[2-(2-hydroxyethoxy)ethoxy]ethoxy]ethyl 4-methylbenzenesulfonate (6 g, 17.22 mmol) in DCM (50 mL) was added PPTS (216.38 mg, 861.05 μmol) and 3,4-dihydro-2H-pyran (1.74 g, 20.67 mmol, 1.89 mL) at 0° C. The resulting mixture was stirred at 25° C. for 16 hours. The reaction mixture was concentrated in vacuo. The residue was purified by column chromatography (silica gel, gradient elution from 50:1 to 5:1 petroleumether:EtOAc) to afford 2-[2-[2-(2-tetrahydropyran-2-yloxyethoxy)ethoxy]ethoxy]ethyl 4-methylbenzenesulfonate (4.2 g, 9.71 mmol, 56.39% yield) as a colorless oil. H NMR: CDCl₃, 400 MHz. δ 7.81-7.79 (m, 2H), 7.35-7.33 (m, 2H), 4.63-4.61 (m, 1H), 4.17-4.14 (m, 2H), 3.68-3.66 (m, 2H), 3.65-3.62 (m, 13H), 3.48-3.58 (m, 1H), 2.44 (s, 3H), 1.84-1.81 (m, 1H), 1.60-1.58 (m, 1H), 1.56-1.51 (m, 4H). LCMS: RT=0.811 min, m/z 450.1 [M+NH₄]⁺.

### C. Step 3

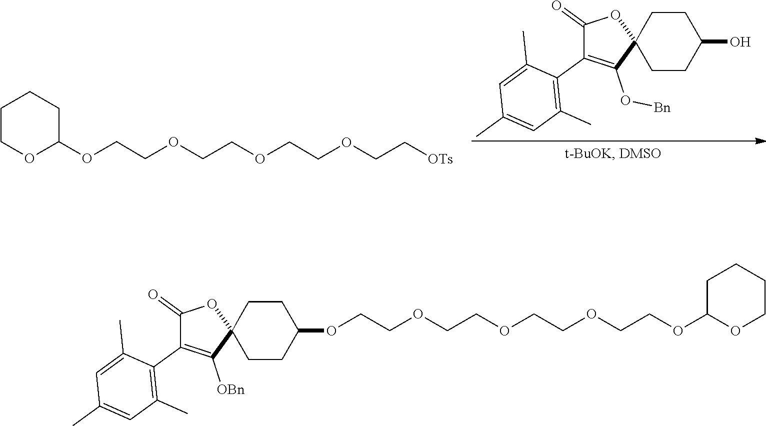

A mixture of (5r,8r)-4-(benzyloxy)-8-hydroxy-3-mesityl-1-oxaspiro[4.5]dec-3-en-2-one (0.6 g, 1.53 mmol; prepared using general methods described herein for the preparation of (5s,8s)-4-(benzyloxy)-8-hydroxy-3-mesityl-1-oxaspiro[4.5]dec-3-en-2-one), 2-[2-[2-(2-tetrahydropyran-2-yloxyethoxy)ethoxy]ethoxy]ethyl 4-methylbenzenesulfonate (1.98 g, 4.59 mmol), and 1 M t-BuOK (1.99 mL, 1.99 mmol) in DMSO (20 mL) was stirred at 40° C. for 16 hours. The reaction mixture was diluted with H₂O (50 mL), and then extracted with DCM (50 mL×5). The combined organic layers were dried over anhydrous Na₂SO₄, filtered, and concentrated in vacuo to afford (5r,8r)-4-(benzyloxy)-3-mesityl-8-(2-(2-(2-(2-((tetrahydro-2H-pyran-2-yl)oxy)ethoxy)ethoxy)ethoxy)ethoxy)-1-oxaspiro[4.5]dec-3-en-2-one (2.2 g, crude) as a yellow oil, which was used directly in the next step without further purification. LCMS: RT=0.994 min, m/z 670.2 [M+NH₄]⁺.

### D. Step 4

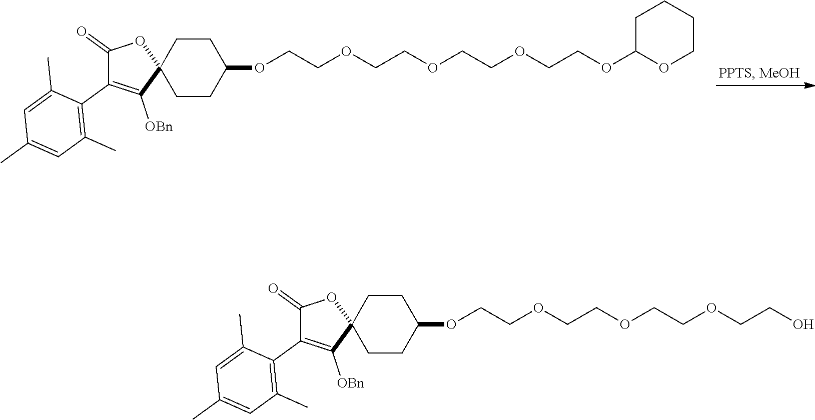

A mixture of (5r,8r)-4-(benzyloxy)-3-mesityl-8-(2-(2-(2-(2-((tetrahydro-2H-pyran-2-yl)oxy)ethoxy)-ethoxy)ethoxy)ethoxy)-1-oxaspiro[4.5]dec-3-en-2-one (2.2 g, 3.37 mmol, crude) and PPTS (254.07 mg, 1.01 mmol) in MeOH (20 mL) was stirred at 40° C. for 16 hours. The reaction mixture was diluted with H₂O (50 mL), and then extracted with DCM (50 mL×5). The combined organic layers were dried over anhydrous Na₂SO₄, filtered, and concentrated in vacuo. The residue was purified with column chromatography (silica gel, gradient elution from 10:1 to 0:1 petroleumether:EtOAc) followed by prep-HPLC (column: Phenomenex Luna C18, 250×50 mm×15 μm, mobile phase: [water(0.225% FA)-ACN], B %: 57-87, 10 min) to afford (5r,8r)-4-(benzyloxy)-8-(2-(2-(2-(2-hydroxyethoxy)ethoxy)ethoxy)ethoxy)-3-mesityl-1-oxaspiro[4.5]dec-3-en-2-one (0.24 g, 422.02 μmol, 12.52% yield) as a colorless oil. LCMS: RT=0.901 min, m/z 569.2 [M+H]⁺.

### E. Step 5

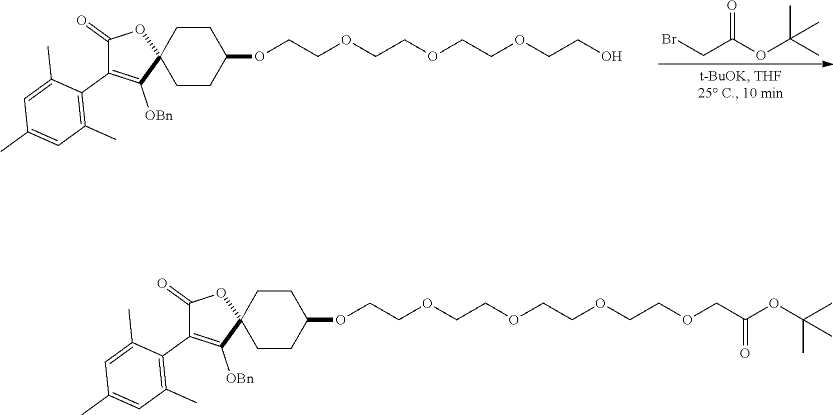

To a stirred mixture of (5r,8r)-4-(benzyloxy)-8-(2-(2-(2-(2-hydroxyethoxy)ethoxy)ethoxy)ethoxy)-3-mesityl-1-oxaspiro[4.5]dec-3-en-2-one (220 mg, 386.85 μmol) and 1M t-BuOK (464.22 μL) in THF (20 mL) was added tert-butyl 2-bromoacetate (90.55 mg, 464.22 μmol, 68.60 μL) at 25° C. The mixture was stirred at 25° C. for 10 minutes. The reaction mixture was quenched with H₂O (30 mL) and extracted with DCM (20 mL×3). The combined organic layers were dried over anhydrous Na₂SO₄, filtered, and concentrated in vacuo. The residue was purified with column chromatography (silica gel, gradient elution from 50:1 to 2:1 petroleumether:EtOAc) to afford tert-butyl 14-(((5r,8r)-4-(benzyloxy)-3-mesityl-2-oxo-1-oxaspiro[4.5]dec-3-en-8-yl)oxy)-3,6,9,12-tetraoxatetradecan-1-oate (0.2 g, 234.32 μmol, 60.57% yield, 80% purity) as a yellow oil. LCMS: RT=0.995 min, m/z 627.2 [M+H-56]⁺.

### F. Step 6

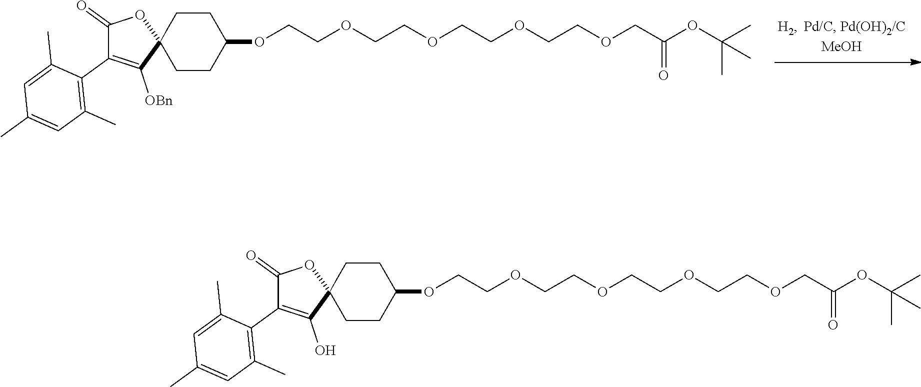

A mixture of tert-butyl 14-(((5r,8r)-4-(benzyloxy)-3-mesityl-2-oxo-1-oxaspiro[4.5]dec-3-en-8-yl)oxy)-3,6,9,12-tetraoxatetradecan-1-oate (160 mg, 187.45 μmol, 80% purity), 10% Pd/C (20 mg) and 20% Pd(OH)₂/C (20 mg) in EtOH (5 mL) was stirred at 25° C. for 2 hours under a H₂ atmosphere (15 Psi). The reaction mixture was filtered and the filtrate concentrated in vacuo to afford tert-butyl 14-(((5r,8r)-4-hydroxy-3-mesityl-2-oxo-1-oxaspiro[4.5]dec-3-en-8-yl)oxy)-3,6,9,12-tetraoxatetradecan-1-oate (110 mg, crude) as a yellow oil. LCMS: RT=0.892 min, m/z 537.2 [M-55]⁺.

### G. Step 7

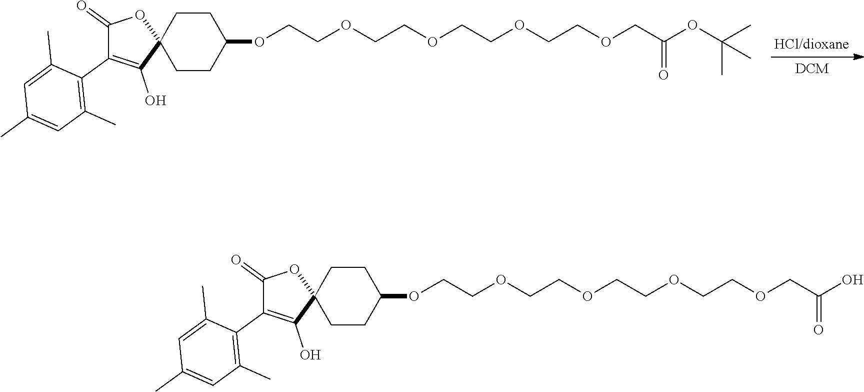

A mixture of tert-butyl 14-(((5r,8r)-4-hydroxy-3-mesityl-2-oxo-1-oxaspiro[4.5]dec-3-en-8-yl)oxy)-3,6,9,12-tetraoxatetradecan-1-oate (100 mg, 168.71 μmol, crude purity) and 4M HCl/dioxane (1.27 mL) in DCM (3 mL) was stirred at 25° C. for 16 hours. The reaction mixture was concentrated in vacuo to afford 14-(((5r,8r)-4-hydroxy-3-mesityl-2-oxo-1-oxaspiro[4.5]dec-3-en-8-yl)oxy)-3,6,9,12-tetraoxatetradecan-1-oic acid (90 mg, crude) as a yellow oil. LCMS: RT=0.879 min, m/z 537.2 [M+H]⁺.

### H. Step 8

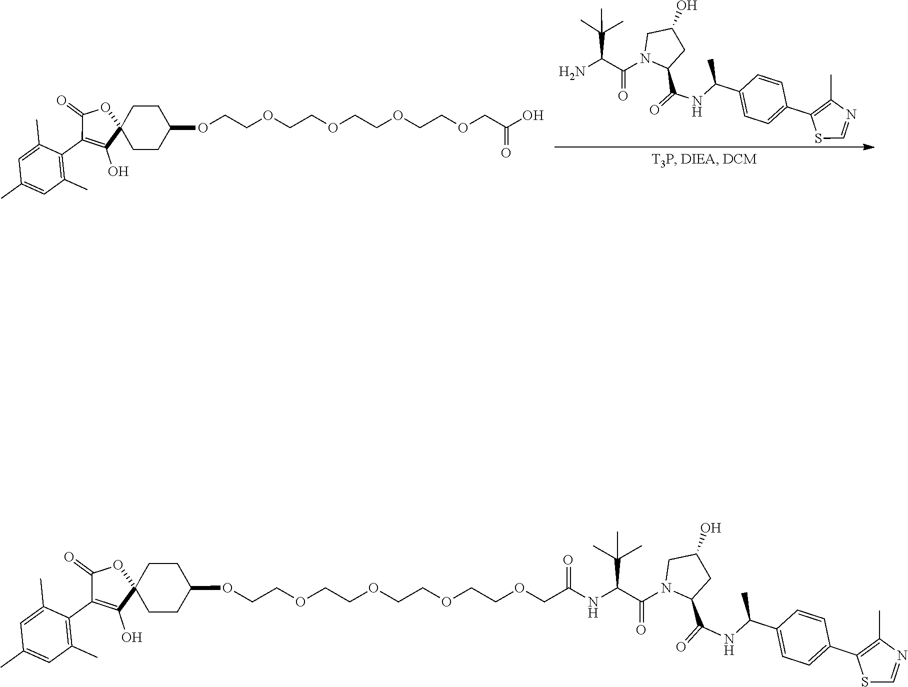

To a stirred solution of 14-(((5r,8r)-4-hydroxy-3-mesityl-2-oxo-1-oxaspiro[4.5]dec-3-en-8-yl)oxy)-3,6,9,12-tetraoxatetradecan-1-oic acid (90 mg, 167.72 μmol, crude purity) in DCM (3 mL) was added 50% T₃P (128.08 mg, 201.26 μmol, 119.70 μL), DIPEA (65.03 mg, 503.16 μmol, 87.64 μL) and (2S,4R)-1-[(2S)-2-amino-3,3-dimethyl-butanoyl]-4-hydroxy-N-[(1S)-1-[4-(4-methylthiazol-5-yl)phenyl]ethyl]pyrrolidine-2-carboxamide (96.82 mg, 201.26 μmol, HCl salt) at 25° C. The reaction mixture was stirred at 25° C. for 16 hours. The reaction mixture was concentrated in vacuo. The residue was purified by prep-HPLC (column: Phenomenex Luna C18, 150×25 mm×10 μm, mobile phase: [water(0.225% FA)-ACN], B %: 48-78, 10 min) to afford (2S,4R)-1-((S)-2-(tert-butyl)-17-(((5r,8r)-4-hydroxy-3-mesityl-2-oxo-1-oxaspiro[4.5]dec-3-en-8-yl)oxy)-4-oxo-6,9,12,15-tetraoxa-3-azaheptadecan-1-oyl)-4-hydroxy-N—((S)-1-(4-(4-methylthiazol-5-yl)phenyl)ethyl)pyrrolidine-2-carboxamide (113.22 mg, 113.32 μmol, 67.56% yield, 96.4% purity) as a yellow gum. H NMR: DMSO-d₆, 400 MHz. δ 8.98 (s, 1H), 8.45 (d, J=7.6 Hz, 1H), 7.48-7.31 (m, 5H), 6.87 (s, 2H), 4.96-4.85 (m, 1H), 4.54 (d, J=9.6 Hz, 1H), 4.44 (t, J=8.0 Hz, 1H), 4.28 (s, 1H), 3.96 (s, 2H), 3.69-3.53 (m, 19H), 2.45 (s, 3H), 2.23 (s, 3H), 2.19-2.11 (m, 2H), 2.03-2.06 (m, 7H), 1.91 (d, J=11.6 Hz, 2H), 1.81-1.66 (m, 3H), 1.37 (d, J=7.2 Hz, 5H), 0.94 (s, 9H). LCMS: RT=2.577 min, m/z 963.5 [M+H]⁺.

### Example A-5. Synthesis of (2S,4R)-1-((S)-2-(tert-butyl)-20-(((5S,8S)-4-hydroxy-3-mesityl-2-oxo-1-oxaspiro[4.5]dec-3-en-8-yl)oxy)-4-oxo-6,9,12,15,18-pentaoxa-3-azaicosanoyl)-4-hydroxy-N—((S)-1-(4-(4-methylthiazol-5-yl)phenyl)ethyl)pyrrolidine-2-carboxamide

### A. Step 1

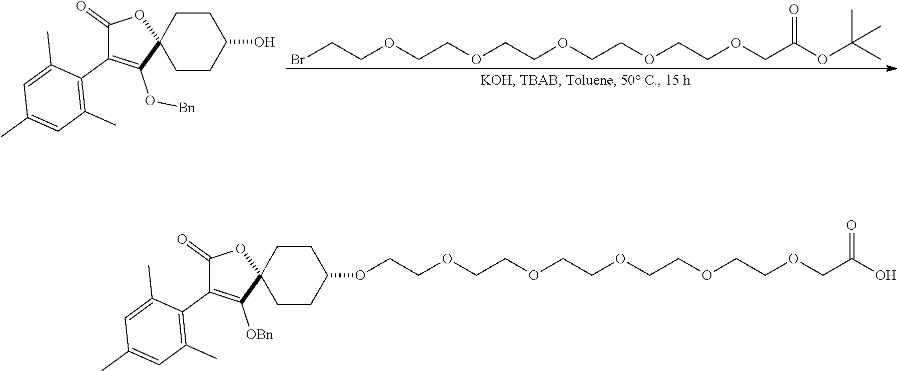

To a mixture of (5s,8s)-4-(benzyloxy)-8-hydroxy-3-mesityl-1-oxaspiro[4.5]dec-3-en-2-one (300 mg, 764.36 μmol; see Example 7, Step 10), tert-butyl 2-[2-[2-[2-[2-(2-bromoethoxy)ethoxy]ethoxy]-ethoxy]ethoxy]acetate (476.18 mg, 1.15 mmol) and TBAB (98.56 mg, 305.74 μmol) in toluene (5 mL) was added KOH (214.42 mg, 3.82 mmol). The mixture was stirred at 50° C. under N₂ for 15 hours. The mixture was poured into water (50 mL) and the pH adjusted to 3-4 by addition of aqueous HCl. The mixture was extracted with EtOAc (50 mL). The organic phase was washed with brine (50 mL×2), dried over anhydrous Na₂SO₄, filtered, and concentrated at reduced pressure. The residue was purified by flash chromatography (silica gel, gradient elution from DCM to 40% MeOH:DCM) followed by prep-TLC (silica gel, 20:1 DCM:MeOH) to give 17-(((5s,8s)-4-(benzyloxy)-3-mesityl-2-oxo-1-oxaspiro[4.5]dec-3-en-8-yl)oxy)-3,6,9,12,15-pentaoxaheptadecanoic acid (63 mg, 88.75 μmol, 11.61% yield, 94.5% purity) as a yellow oil. LCMS: RT=0.999 min, m/z 671.5 [M+H]⁺.

### B. Step 2

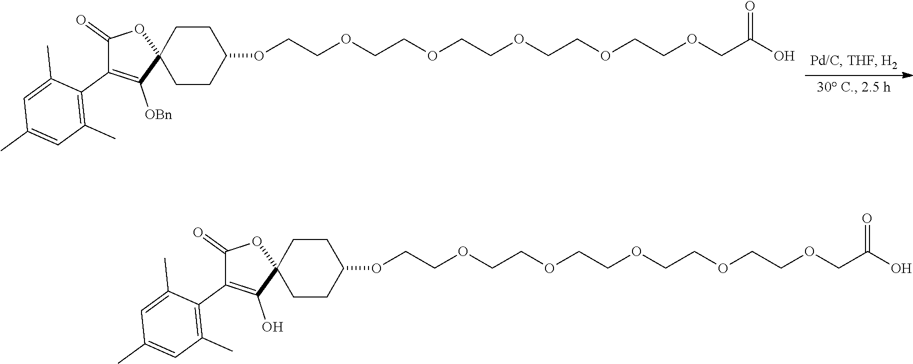 [SMILES: Cc1cc(C)c(C2=C(OCc3ccccc3)[C@]3(CC[C@H](OCCOCCOCCOCCOCCOCC(=O)O)CC3)OC2=O)c(C)c1 ; Cc1cc(C)c(C2=C(O)[C@]3(CC[C@H](OCCOCCOCCOCCOCCOCC(=O)O)CC3)OC2=O)c(C)c1]

To a solution of 17-(((5s,8s)-4-(benzyloxy)-3-mesityl-2-oxo-1-oxaspiro[4.5]dec-3-en-8-yl)oxy)-3,6,9,12,15-pentaoxaheptadecanoic acid (53 mg, 79.01 μmol) in THE (3 mL) was added 10% Pd/C (10 mg) under N₂. The mixture was degassed and purged with H₂ (3×). The mixture was stirred at 30° C. under 15 psi of H₂ (balloon) for 2 hours. LCMS indicated remaining starting material. The mixture was filtered, and the filtrate concentrated to dryness at reduced pressure. The residue was re-subjected to the above conditions for 0.5 hours, catalyst removed by filtration, and the filtrate concentrated to dryness at reduced pressure to afford 17-(((5s,8s)-4-hydroxy-3-mesityl-2-oxo-1-oxaspiro[4.5]dec-3-en-8-yl)oxy)-3,6,9,12,15-pentaoxaheptadecanoic acid (50 mg, crude) as a yellow oil, which was used in the next step without further purification. LCMS: RT=0.859 min, m/z 581.4 [M+H]⁺.

### C. Step 3

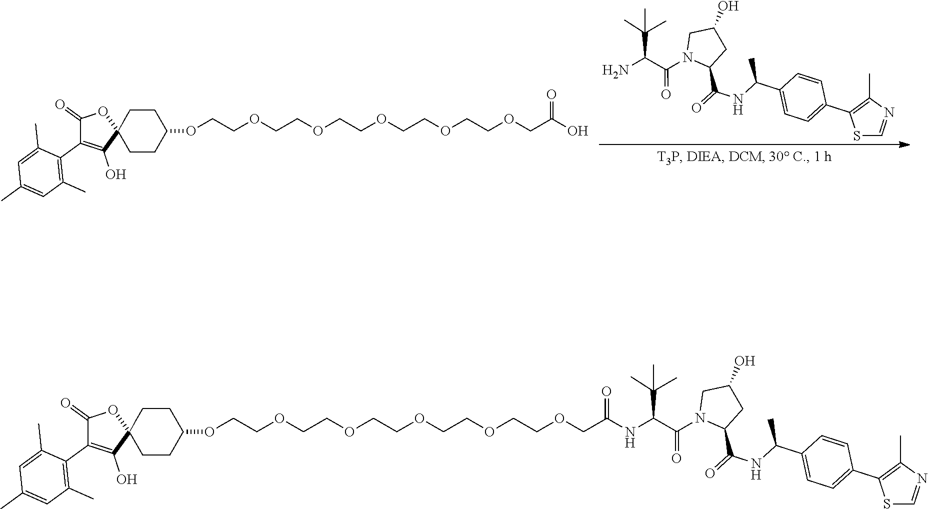

To a mixture of 17-(((5s,8s)-4-hydroxy-3-mesityl-2-oxo-1-oxaspiro[4.5]dec-3-en-8-yl)oxy)-3,6,9,12,15-pentaoxaheptadecanoic acid (50 mg, crude), (2S,4R)-1-[(2S)-2-amino-3,3-dimethyl-butanoyl]-4-hydroxy-N-[(1S)-1-[4-(4-methylthiazol-5-yl)phenyl]ethyl]pyrrolidine-2-carboxamide (62.13 mg, 129.16 μmol, HCl salt) and DIPEA (44.52 mg, 344.43 μmol, 59.99 μL) in DCM (2 mL) was added 50% T₃P (82.19 mg, 129.16 μmol, 76.82 μL). The mixture was stirred at 30° C. under N₂ for 1 hour. The mixture was diluted with DCM (20 mL), washed with 0.1M aqueous HCl (20 mL) and brine (20 mL×2). The organic phase was dried over anhydrous Na₂SO₄, filtered, and concentrated to dryness at reduced pressure. The residue was purified by prep-HPLC (column: Phenomenex Gemini-NX C18, 75×30 mm×3 μm, mobile phase: [water (10 mM NH₄HCO₃)-ACN], B %: 12-42, 8 min) to afford (2S,4R)-1-((S)-2-(tert-butyl)-20-(((5s,8s)-4-hydroxy-3-mesityl-2-oxo-1-oxaspiro[4.5]dec-3-en-8-yl)oxy)-4-oxo-6,9,12,15,18-pentaoxa-3-azaicosanoyl)-4-hydroxy-N—((S)-1-(4-(4-methylthiazol-5-yl)phenyl)ethyl)pyrrolidine-2-carboxamide. HNMR: CDCl₃, 400 MHz. δ 8.48 (s, 1H), 7.67-7.62 (m, 1H), 7.45-7.40 (m, 1H), 7.38-7.34 (m, 2H), 7.32-7.28 (m, 2H), 6.79 (d, J=8.8 Hz, 2H), 5.05-4.96 (m, 1H), 4.67 (t, J=8.0 Hz, 1H), 4.54 (d, J=8.4 Hz, 1H), 4.40-4.35 (m, 1H), 4.12-4.03 (m, 2H), 4.00-3.94 (m, 1H), 3.72-3.56 (m, 21H), 3.42-3.35 (m, 1H), 2.51 (s, 3H), 2.33-2.25 (m, 1H), 2.21-2.07 (m, 10H), 2.02-1.92 (m, 4H), 1.74-1.60 (m, 4H), 1.39 (d, J=7.2 Hz, 3H), 1.05 (s, 9H). LCMS: RT=2.458 min, m/z 1007.5 [M+H]⁺.

### Example A-6. Synthesis of (2S,4R)-1-((S)-2-(tert-butyl)-20-(((5R,8R)-4-hydroxy-3-mesityl-2-oxo-1-oxaspiro[4.5]dec-3-en-8-yl)oxy)-4-oxo-6,9,12,15,18-pentaoxa-3-azaicosanoyl)-4-hydroxy-N—((S)-1-(4-(4-methylthiazol-5-yl)phenyl)ethyl)pyrrolidine-2-carboxamide

### A. Step 1

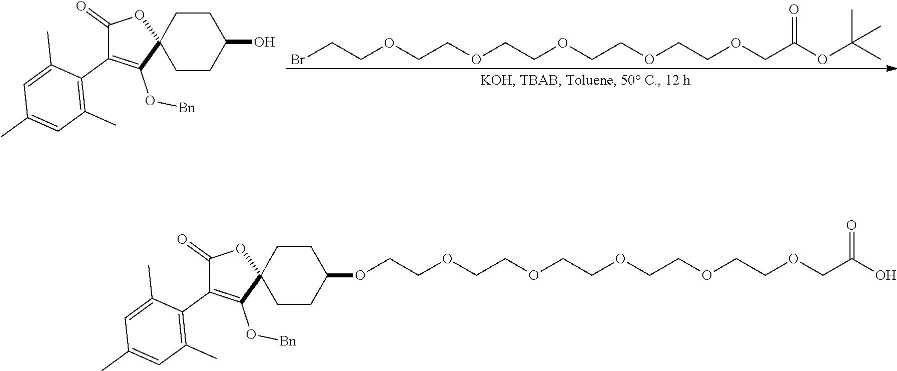

To a mixture of (5r,8r)-4-(benzyloxy)-8-hydroxy-3-mesityl-1-oxaspiro[4.5]dec-3-en-2-one (300.00 mg, 764.36 μmol; prepared using general methods described herein for the preparation of (5s,8s)-4-(benzyloxy)-8-hydroxy-3-mesityl-1-oxaspiro[4.5]dec-3-en-2-one), tert-butyl 2-[2-[2-[2-[2-(2-bromo-ethoxy)ethoxy]ethoxy]ethoxy]ethoxy]acetate (476.18 mg, 1.15 mmol) and TBAB (98.56 mg, 305.74 μmol) in toluene (10 mL) was added KOH (214.42 mg, 3.82 mmol). The mixture was stirred at 50° C. under N₂ for 12 hours. The mixture was poured into water (50 mL) and the pH adjusted to 3-4 by addition of aqueous HCl. The mixture was extracted with EtOAc (50 mL). The organic phase was washed with brine (50 mL×2), dried over anhydrous Na₂SO₄, filtered, and concentrated in vacuo. The residue was purified by flash chromatography (silica gel, gradient elution from 0 to 40% MeOH in DCM) to give 17-(((5r,8r)-4-(benzyloxy)-3-mesityl-2-oxo-1-oxaspiro[4.5]dec-3-en-8-yl)oxy)-3,6,9,12,15-pentaoxaheptadecanoic acid (26 mg) as a yellow oil. LCMS: RT=1.000 min, m/z 671.5 [M+H]⁺.

### B. Step 2

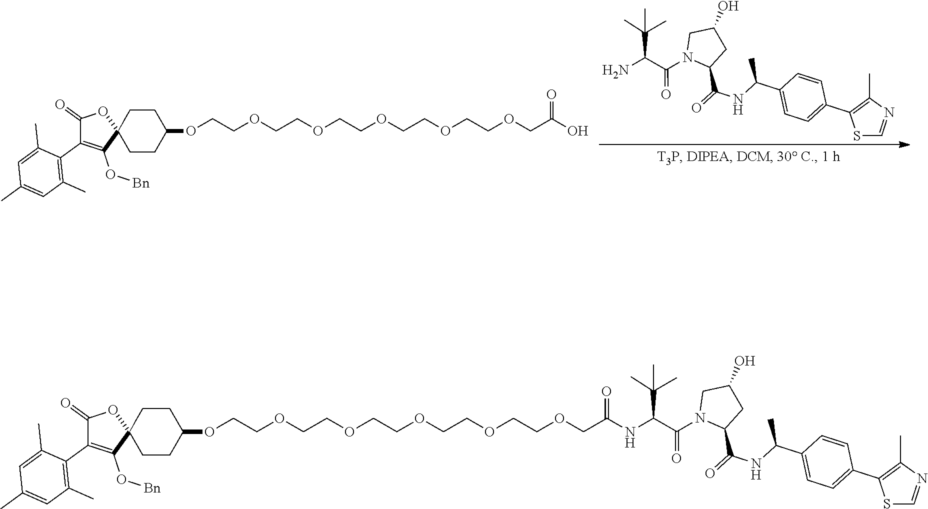

To a mixture of 17-(((5r,8r)-4-(benzyloxy)-3-mesityl-2-oxo-1-oxaspiro[4.5]dec-3-en-8-yl)oxy)-3,6,9,12,15-pentaoxaheptadecanoic acid (26.00 mg, 38.76 μmol), (2S,4R)-1-((S)-2-amino-3,3-dimethylbutanoyl)-4-hydroxy-N—((S)-1-(4-(4-methylthiazol-5-yl)phenyl)ethyl)pyrrolidine-2-carboxamide (27.97 mg, 58.14 μmol, HCl salt) and DIPEA (20.04 mg, 155.04 μmol, 27.00 μL) in DCM (2 mL) was added 50% T₃P (37.00 mg, 58.14 μmol, 34.58 μL). The mixture was stirred at 30° C. under N₂ for 1 hour, poured into 0.1 M aqueous HCl (20 mL) and extracted with DCM (20 mL). The organic phase was washed with brine (20 mL×2), dried over anhydrous Na₂SO₄, filtered and concentrated in vacuo to give (2S,4R)-1-((S)-20-(((5r,8r)-4-(benzyloxy)-3-mesityl-2-oxo-1-oxaspiro[4.5]dec-3-en-8-yl)oxy)-2-(tert-butyl)-4-oxo-6,9,12,15,18-pentaoxa-3-azaicosanoyl)-4-hydroxy-N—((S)-1-(4-(4-methylthiazol-5-yl)phenyl)ethyl)pyrrolidine-2-carboxamide (40 mg) as a yellow oil, which was used in the next step without further purification. LCMS: RT=1.065 min, m/z 1119.9 [M+Na]⁺.

### C. Step 3

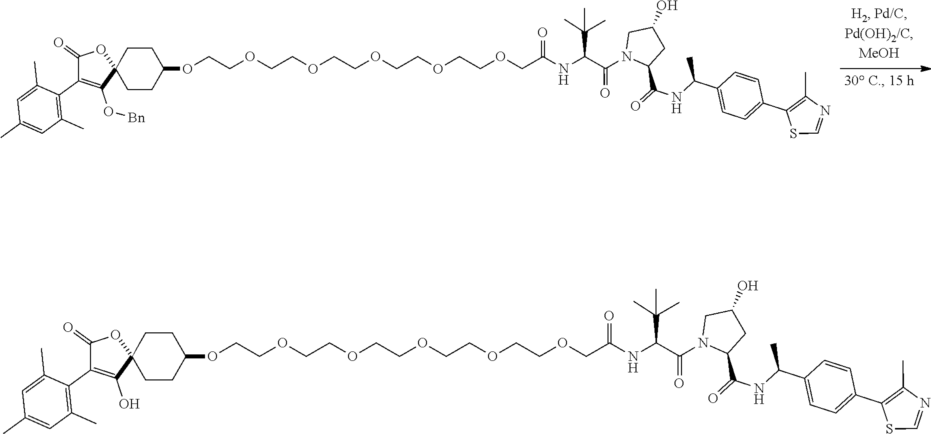

To a solution of (2S,4R)-1-((S)-20-(((5r,8r)-4-(benzyloxy)-3-mesityl-2-oxo-1-oxaspiro[4.5]dec-3-en-8-yl)oxy)-2-(tert-butyl)-4-oxo-6,9,12,15,18-pentaoxa-3-azaicosanoyl)-4-hydroxy-N—((S)-1-(4-(4-methylthiazol-5-yl)phenyl)ethyl)pyrrolidine-2-carboxamide (40.00 mg, 36.45 μmol) in MeOH (2 mL) was added 10% Pd/C (10 mg) under N₂. The mixture was degassed and purged with H₂ (3×). The mixture was stirred at 30° C. under 15 psi H₂ (balloon) for 1 hour at which point LCMS indicated remaining starting material. The mixture was treated with 20% Pd(OH)₂/C (10 mg) and maintained under H₂ as above for 15 hours. The mixture was filtered, and the filtrate concentrated in vacuo. The residue was purified by prep-HPLC (column: Phenomenex Luna C18, 150×25 mm×10 μm, mobile phase: [water (0.225% FA)-ACN], B %: 48-78, 10 min) to give (2S,4R)-1-((S)-2-(tert-butyl)-20-(((5r,8r)-4-hydroxy-3-mesityl-2-oxo-1-oxaspiro[4.5]dec-3-en-8-yl)oxy)-4-oxo-6,9,12,15,18-pentaoxa-3-azaicosanoyl)-4-hydroxy-N—((S)-1-(4-(4-methylthiazol-5-yl)phenyl)ethyl)pyrrolidine-2-carboxamide (9.59 mg, 9.36 μmol, 25.68% yield, 98.3% purity) as an offwhite gum. HNMR: CDCl₃, 400 MHz. δ 8.52 (s, 1H), 7.47-7.28 (m, 6H), 6.85 (s, 2H), 5.13-5.03 (m, 1H), 4.76-4.68 (m, 1H), 4.58-4.45 (m, 2H), 4.13-4.07 (m, 1H), 4.05-3.90 (m, 2H), 3.72-3.46 (m, 22H), 2.59-2.50 (m, 4H), 2.45-2.37 (m, 2H), 2.25 (s, 3H), 2.17 (s, 6H), 2.04-1.90 (m, 5H), 1.60-1.53 (m, 2H), 1.49-1.43 (m, 3H), 1.09-1.01 (m, 9H). LCMS: RT=2.905 min, m/z 1008.5 [M+H]⁺.

### Example A-7. Synthesis of (2S,4R)-1-((S)-2-(tert-butyl)-23-(((5S,8S)-4-hydroxy-3-mesityl-2-oxo-1-oxaspiro[4.5]dec-3-en-8-yl)oxy)-4-oxo-6,9,12,15,18,21-hexaoxa-3-azatricosanoyl)-4-hydroxy-N—((S)-1-(4-(4-methylthiazol-5-yl)phenyl)ethyl)pyrrolidine-2-carboxamide

### A. Step 1

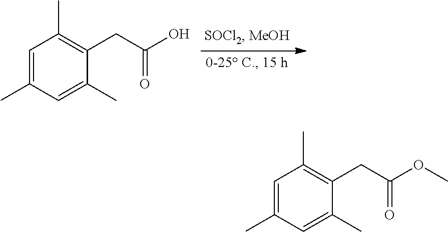

To a stirred suspension of 2-(2,4,6-trimethylphenyl)acetic acid (100 g, 561.08 mmol) in MeOH (1 L) was added SOCl₂ (133.50 g, 1.12 mol, 81.40 mL) dropwise at 0° C. over 1 hour. The mixture was stirred at 25° C. for 15 hours at which point the mixture had turned clear. The mixture was concentrated in vacuo. The residue was diluted with saturated aqueous NaHCO₃ (1 L) and extracted with EtOAc (1 L). The organic phase was washed with brine (1 L×2), dried over anhydrous Na₂SO₄, filtered and concentrated in vacuo to give methyl 2-(2,4,6-trimethylphenyl)acetate (104.2 g, 541.99 mmol, 96.60% yield) as a yellow liquid, which was used in the next step without further purification. HNMR: CDCl₃, 400 MHz. δ 6.89 (s, 2H), 3.69 (s, 3H), 3.68 (s, 2H), 2.31 (s, 6H), 2.28 (s, 3H).

### B. Step 2

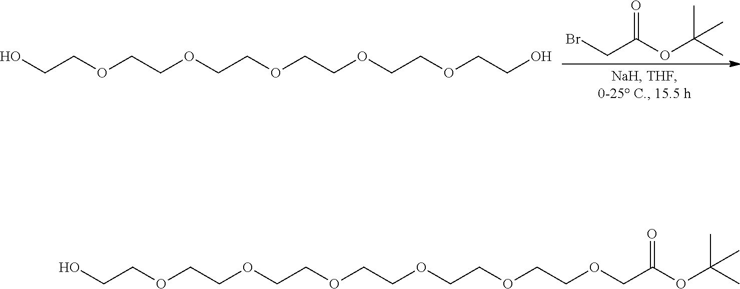

To a stirred solution of 2-[2-[2-[2-[2-(2-hydroxyethoxy)ethoxy]ethoxy]ethoxy]ethoxy]ethanol (14.47 g, 51.27 mmol) in THF (100 mL) was added 60% NaH (1.13 g, 28.20 mmol) at 0° C. under N₂. The mixture was stirred at 0° C. for 30 minutes. Tert-butyl 2-bromoacetate (5 g, 25.63 mmol, 3.79 mL) was then added. The mixture was stirred at 25° C. for another 15 hours. The mixture was diluted with water (500 mL) and extracted with EtOAc (500 mL×2). The combined organic phases were dried over anhydrous Na₂SO₄, filtered, and concentrated in vacuo. The residue was purified by column chromatography (silica gel, gradient elution from 3:1 to 1:1 petroleum ether:EtOAc followed by 30:1 DCM:MeOH) to give tert-butyl 2-[2-[2-[2-[2-[2-(2-hydroxyethoxy)ethoxy]ethoxy]ethoxy]ethoxy]ethoxy]acetate 4 g, 10.09 mmol, 39.36% yield) as a colorless oil. HNMR: CDCl₃, 400 MHz. δ 4.01 (s, 2H), 3.73-3.60 (m, 24H), 1.47 (s, 9H).

### C. Step 3

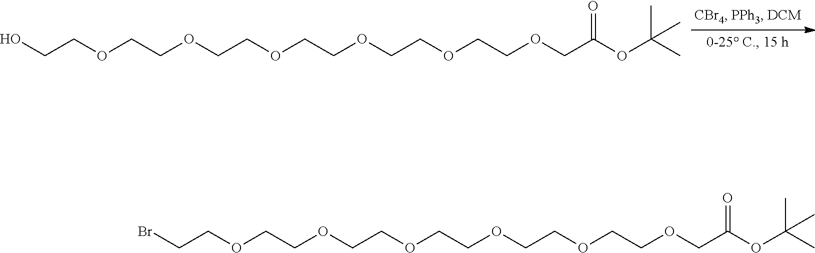 [SMILES: CC(C)(C)OC(=O)COCCOCCOCCOCCOCCOCCO ; CC(C)(C)OC(=O)COCCOCCOCCOCCOCCOCCBr]

To a stirred mixture of tert-butyl 2-[2-[2-[2-[2-[2-(2-hydroxyethoxy)ethoxy]ethoxy]ethoxy]-ethoxy]ethoxy]acetate (4 g, 10.09 mmol) and CBr₄ (5.02 g, 15.13 mmol) in DCM (40 mL) was added PPh₃ (3.97 g, 15.13 mmol) portion-wise at 0° C. The mixture was stirred at 25° C. under N₂ for 15 hours. The mixture was diluted with DCM (160 mL) and washed with brine (200 mL). The organic phase was dried over anhydrous Na₂SO₄, filtered, and concentrated in vacuo. The residue was triturated with 10:1 petroleumether:EtOAc (66 mL) the precipitated Ph₃PO was removed by filtration and the filtrate concentrated at reduced pressure. The residue was subjected to column chromatography (silica gel, gradient elution from 3:1 to 1:2 petroleum ether:EtOAc) to give tert-butyl 2-[2-[2-[2-[2-[2-(2-bromoethoxy)ethoxy]ethoxy]ethoxy]ethoxy]ethoxy]acetate (2.56 g, 5.57 mmol, 55.24% yield) as a yellow oil. HNMR: CDCl₃, 400 MHz. δ 4.02 (s, 2H), 3.82 (t, J=6.4 Hz, 2H), 3.72-3.64 (m, 20H), 3.48 (t, 0.1=6.4 Hz, 2H), 1.48 (s, 9H).

### D. Step 4

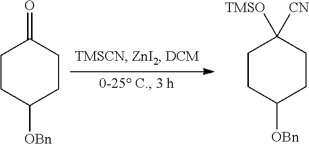

To a stirred mixture of 4-benzyloxycyclohexanone (35 g, 171.35 mmol) and ZnI₂ (5.47 g, 17.13 mmol) in DCM (350 mL) was added TMSCN (25.50 g, 257.02 mmol, 32.15 mL) dropwise at 0° C. under N₂. The mixture was stirred at 25° C. for 3 hours after which the mixture was concentrated in vacuo. The residue was purified by column chromatography (silica gel, gradient elution from 0 to 2% EtOAc in petroleum ether) to give 4-benzyloxy-1-trimethylsilyloxy-cyclohexanecarbonitrile (37.23 g, 122.68 mmol, 71.60% yield) as a colorless oil. HNMR: CDCl₃, 400 MHz. δ 7.40-7.28 (m, 5H), 4.52 (s, 2H), 3.60-3.43 (m, 1H), 2.12-1.68 (m, 8H), 0.27-0.23 (m, 9H).

### E. Step 5

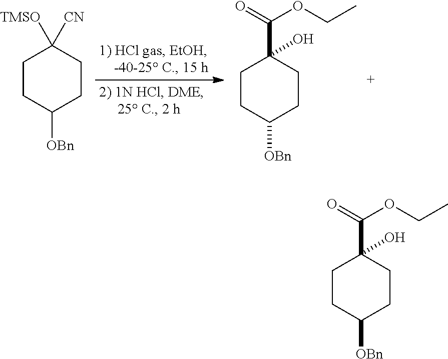

To a stirred solution of 4-benzyloxy-1-trimethylsilyloxy-cyclohexanecarbonitrile (10 g, 32.95 mmol) in EtOH (150 mL) at −40° C. was bubbled HCl gas (45 g, 1.23 mol, 44.12 mL). After stirring at 25° C. for 15 hours, the mixture was concentrated in vacuo. The residue was suspended in DME (100 mL) and treated with 1 M aqueous HCl (49.43 mL). The mixture was stirred at 25° C. for another 2 hours, mixed with saturated NaHCO₃ aqueous solution (500 mL) and extracted with EtOAc (500 mL). The organic phase was washed with brine (500 mL×2), dried over anhydrous Na₂SO₄, filtered, and concentrated in vacuo. The residue was purified by flash chromatography (silica gel, gradient elution from 0 to 19% EtOAc in petroleum ether) to afford (1s,4s)-ethyl 4-(benzyloxy)-1-hydroxycyclohexanecarboxylate (3.94 g, 14.16 mmol, 42.96% yield, 100% purity) as a yellow oil and (1r,4r)-ethyl 4-(benzyloxy)-1-hydroxycyclohexanecarboxylate (820 mg, 2.95 mmol, 8.94% yield, 100% purity) as a yellow oil. Data for (1s,4s)-ethyl 4-(benzyloxy)-1-hydroxycyclohexanecarboxylate: HNMR: DMSO-d₆, 400 MHz. δ 7.37-7.23 (m, 5H), 5.18 (s, 1H), 4.49 (s, 2H), 4.07 (q, J=7.2 Hz, 2H), 3.39-3.34 (m, 1H), 1.81-1.53 (m, 8H), 1.18 (t, J=7.2 Hz, 3H). LCMS: RT=0.889 min, m/z 301.2 [M+Na]⁺. Data for (1r,4r)-ethyl 4-(benzyloxy)-1-hydroxycyclohexanecarboxylate: HNMR: DMSO-d₆, 400 MHz. δ 7.35-7.26 (m, 5H), 5.19 (s, 1H), 4.46 (s, 2H), 4.07 (q, J=7.2 Hz, 2H), 3.56-3.54 (m, 1H), 2.01-1.95 (m, 2H), 1.80-1.70 (m, 2H), 1.63-1.61 (m, 2H), 1.44-1.40 (m, 2H), 1.19 (t, J=7.2 Hz, 3H). LCMS: RT=0.897 min, m/z 301.2 [M+Na]⁺.

### F. Step 6

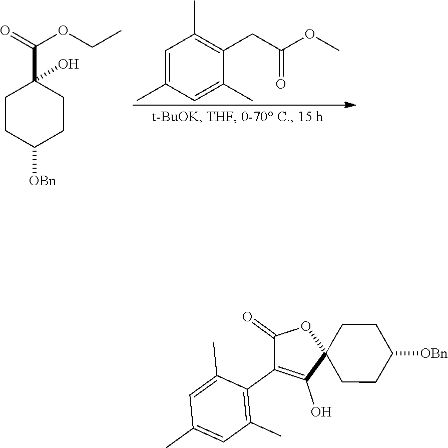

To a stirred mixture of (1s,4s)-ethyl 4-(benzyloxy)-1-hydroxycyclohexanecarboxylate (2.44 g, 8.77 mmol) and methyl 2-(2,4,6-trimethylphenyl)acetate (1.85 g, 9.64 mmol) in THF (50 mL) at 0° C. under N₂ was added 1 M t-BuOK (19.29 mL). The mixture was stirred at 70° C. for 15 hours, cooled to 25° C., and poured into 0.2 M aqueous HCl solution (250 mL). The resulting mixture was extracted with EtOAc (250 mL). The organic phase was washed with brine (250 mL×2), dried over anhydrous Na₂SO₄, filtered, and concentrated in vacuo. The residue was combined with the crude products from 3 similar reactions and subjected to flash chromatography (silica gel, gradient elution from 0 to 34% EtOAc in petroleum ether) to give (5S,8S)-8-(benzyloxy)-4-hydroxy-3-mesityl-1-oxaspiro[4.5]dec-3-en-2-one (94.0% purity) as a yellow solid. HNMR: DMSO-d₆, 400 MHz. δ 12.03 (br s, 1H), 7.40-7.31 (m, 5H), 6.88 (s, 2H), 4.57 (s, 2H), 3.54-3.39 (m, 1H), 2.24 (s, 3H), 2.12-1.95 (m, 10H), 1.71-1.66 (m, 2H), 1.63-1.54 (m, 2H). LCMS: RT=0.980 min, m/z 393.3 [M+H]⁺.

### G. Step 7

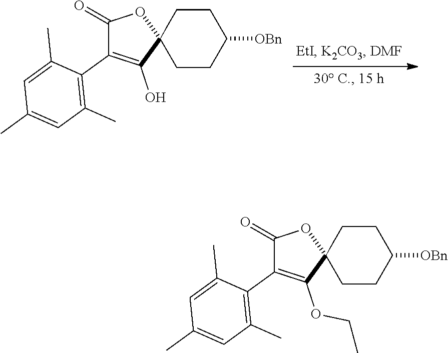

To a stirred mixture of (5s,8s)-8-(benzyloxy)-4-hydroxy-3-mesityl-1-oxaspiro[4.5]dec-3-en-2-one (4.08 g, 10.40 mmol) and K₂CO₃ (2.87 g, 20.79 mmol) in DMF (40 mL) at 25° C. was added ethyl iodide (2.43 g, 15.59 mmol, 1.25 mL). The mixture was stirred at 30° C. under N₂ for 15 hours and then poured into water (500 mL) and extracted with EtOAc (500 mL). The organic phase was washed with brine (500 mL×2), dried over anhydrous Na₂SO₄, filtered, and concentrated in vacuo. The residue was purified by flash chromatography (silica gel, gradient elution from 0 to 17% EtOAc in petroleum ether) to afford (5s,8s)-8-(benzyloxy)-4-ethoxy-3-mesityl-1-oxaspiro[4.5]dec-3-en-2-one (3.6 g, 8.30 mmol, 79.80% yield, 96.9% purity) as a yellow oil. HNMR: DMSO-d₆, 400 MHz. δ 7.36-7.28 (m, 5H), 6.91 (s, 2H), 4.56 (s, 2H), 3.71 (q, J=6.8 Hz, 2H), 3.53-3.44 (m, 1H), 2.24 (s, 3H), 2.15-2.05 (m, 8H), 1.96-1.85 (m, 2H), 1.76-1.70 (m, 2H), 1.60-1.52 (m, 2H), 1.07 (t, J=6.8 Hz, 3H). LCMS: RT=1.094 min, m/z 421.4 [M+H]⁺.

### H. Step 8

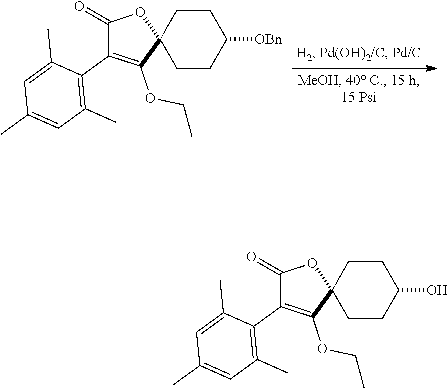

To a solution of (5s,8s)-8-(benzyloxy)-4-ethoxy-3-mesityl-1-oxaspiro[4.5]dec-3-en-2-one (3.6 g, 8.56 mmol) in MeOH (40 mL) under N₂ was added 10% Pd/C (0.3 g) and 20% Pd(OH)₂/C (0.3 g). The mixture was purged with H₂ (3×) and stirred at 40° C. under 15 psi of H₂ (balloon) for 15 hours. The mixture was filtered and the filtrate concentrated in vacuo to afford (5s,8s)-4-ethoxy-8-hydroxy-3-mesityl-1-oxaspiro[4.5]dec-3-en-2-one (2.8 g) as a pale solid, which was used in the next step without further purification. LCMS: RT=0.919 min, m/z 331.3 [M+H]⁺.

### I. Step 9

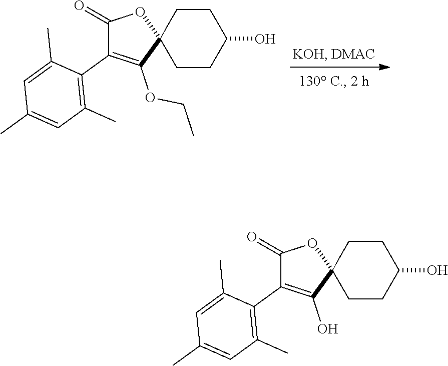

A mixture of (5s,8s)-4-ethoxy-8-hydroxy-3-mesityl-1-oxaspiro[4.5]dec-3-en-2-one (1 g, 3.03 mmol) and KOH (849.01 mg, 15.13 mmol) in dimethylacetamide (10 mL) was stirred at 130° C. for 2 hours and cooled to 25° C. The mixture was combined with the reaction mixture from a similar reaction, poured into water, extracted with EtOAc (250 mL), and the organic layer discarded. The pH of the aqueous phase was adjusted to 3-4 by addition of 2 M aqueous HCl and then extracted with EtOAc (250 mL). The EtOAc solution was washed with brine (250 mL×2), dried over anhydrous Na₂SO₄, filtered and concentrated in vacuo to afford crude (5s,8s)-4,8-dihydroxy-3-mesityl-1-oxaspiro[4.5]dec-3-en-2-one as a pale solid, which was used in the next step without further purification. LCMS: RT=0.822 min, m % z 303.2 [M+H]⁺.

### J. Step 10

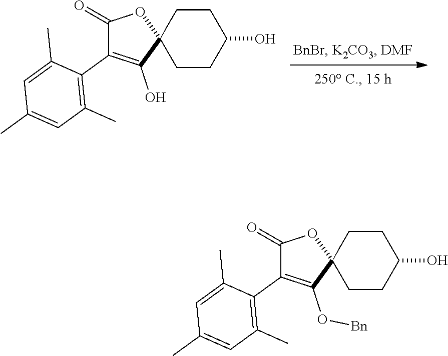

To a stirred mixture of (5s,8s)-4,8-dihydroxy-3-mesityl-1-oxaspiro[4.5]dec-3-en-2-one (2.2 g, 7.28 mmol) and K₂CO₃ (2.01 g, 14.55 mmol) in DMF (22 mL) at 25° C. was added benzyl bromide (1.49 g, 8.73 mmol, 1.04 mL). The mixture was stirred at 25° C. for 15 hours, diluted with water (150 mL) and extracted with EtOAc (150 mL). The organic phase was washed with brine (150 mL×2), dried over anhydrous Na₂SO₄, filtered and concentrated in vacuo. The residue was purified by flash chromatography (silica gel, gradient elution from 0 to 71% EtOAc in petroleum ether) to afford (5s,8s)-4-(benzyloxy)-8-hydroxy-3-mesityl-1-oxaspiro[4.5]dec-3-en-2-one (1.75 g, 4.46 mmol, 61.28% yield, 100% purity) as a white solid. HNMR: CDCl₃, 400 MHz. δ 7.34-7.27 (m, 3H), 7.03-6.98 (m, 2H), 6.89 (s, 2H), 4.77 (s, 2H), 3.78-3.63 (m, 1H), 2.30 (s, 3H), 2.10 (s, 6H), 2.05-1.99 (m, 4H), 1.88-1.76 (m, 4H), 1.52 (d, J=5.6 Hz, 1H).

LCMS: RT=0.982 min, m/z 393.3 [M+H]⁺.

### K. Step 11

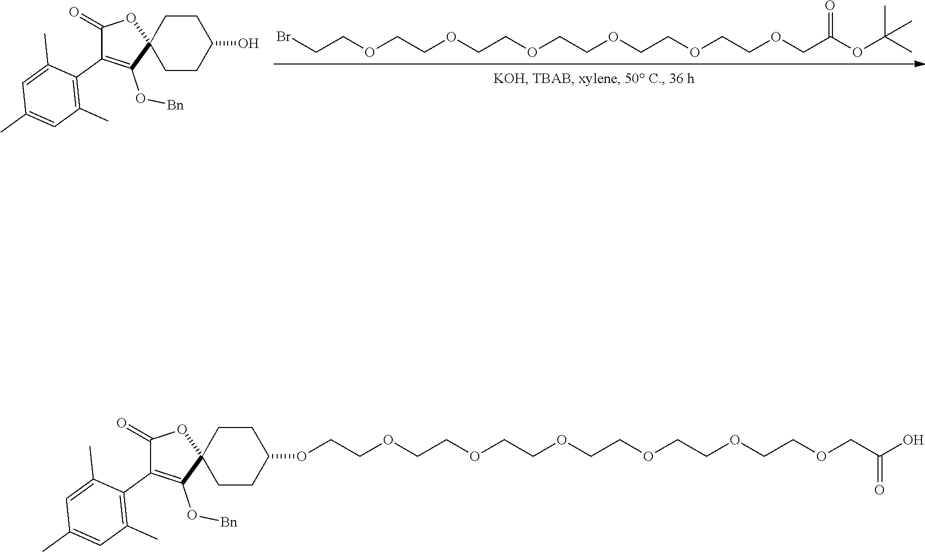

To a stirred mixture of (5s,8s)-4-(benzyloxy)-8-hydroxy-3-mesityl-1-oxaspiro[4.5]dec-3-en-2-one (200 mg, 509.57 μmol), tert-butyl 2-[2-[2-[2-[2-[2-(2-bromoethoxy)ethoxy]ethoxy]ethoxy]ethoxy]ethoxy]acetate (351.12 mg, 764.36 μmol), and KOH (142.95 mg, 2.55 mmol) in xylene (2 mL) was added TBAB (32.85 mg, 101.91 μmol) at 25° C. The mixture was stirred at 50° C. for 36 hours, diluted with water (20 mL) and then acidified to pH 3-4 by addition of 2 M aqueous HCL. The mixture was extracted with EtOAc (20 mL). The organic phase was washed with brine (20 mL×2), dried over anhydrous Na₂SO₄, filtered, and concentrated in vacuo. The residue was purified by flash chromatography (silica gel, gradient elution from 0 to 30% MeOH in DCM) to give 20-(((5s,8s)-4-(benzyloxy)-3-mesityl-2-oxo-1-oxaspiro[4.5]dec-3-en-8-yl)oxy)-3,6,9,12,15,18-hexaoxaicosan-1-oic acid (50 mg) as a yellow oil, which was used in the next step without further purification. LCMS: RT=1.006 min, m/z 715.6 [M+H]⁺.

### L. Step 12

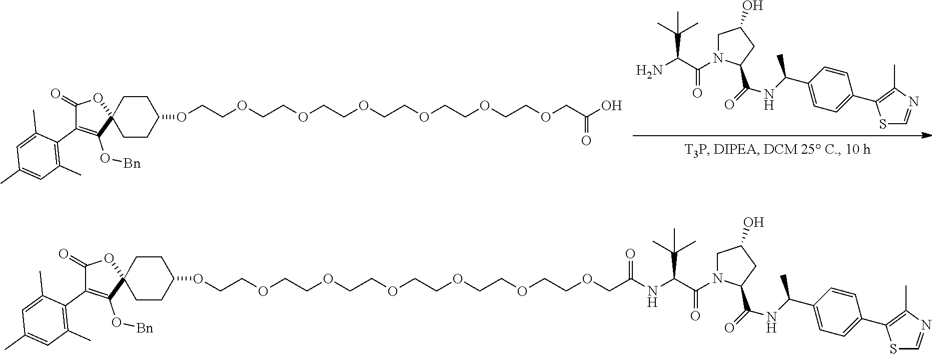

To a mixture of 20-(((5s,8s)-4-(benzyloxy)-3-mesityl-2-oxo-1-oxaspiro[4.5]dec-3-en-8-yl)oxy)-3,6,9,12,15,18-hexaoxaicosan-1-oic acid (50.00 mg, 69.95 μmol), (2S,4R)-1-[(2S)-2-amino-3,3-dimethyl-butanoyl]-4-hydroxy-N-[(1S)-1-[4-(4-methylthiazol-5-yl)phenyl]ethyl]pyrrolidine-2-carboxamide (50.47 mg, 104.92 μmol, HCl salt) and DIPEA (36.16 mg, 279.78 μmol, 48.73 μL) in DCM (3 mL) was added 50% T₃P (66.77 mg, 104.92 μmol, 62.40 μL). The mixture was stirred under N₂ at 25° C. for 10 hours, diluted with water (20 mL), and acidified to pH 3-4 by addition of aqueous 2 M aqueous HCl. The mixture was extracted with DCM (20 mL). The organic phase was washed with brine (20 mL×2), dried over anhydrous Na₂SO₄, filtered, and concentrated in vacuo to afford (2S,4R)-1-((S)-23-(((5s,8s)-4-(benzyloxy)-3-mesityl-2-oxo-1-oxaspiro[4.5]dec-3-en-8-yl)oxy)-2-(tert-butyl)-4-oxo-6,9,12,15,18,21-hexaoxa-3-azatricosan-1-oyl)-4-hydroxy-N—((S)-1-(4-(4-methylthiazol-5-yl)phenyl)ethyl)pyrrolidine-2-carboxamide (90 mg) as a yellow oil, which was used in the next step without further purification. LCMS: RT=1.064 min, m/z 1163.9 [M+Na]⁺.

### M. Step 13

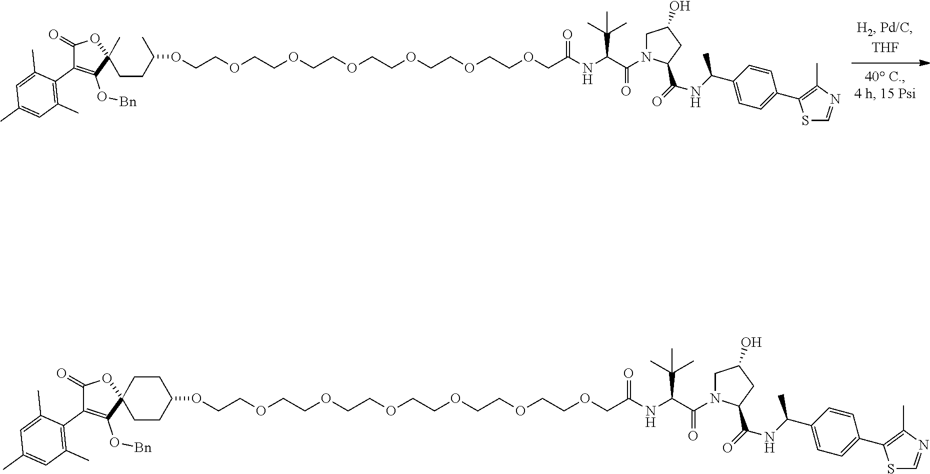

To a solution of (2S,4R)-1-((S)-23-(((5s,8s)-4-(benzyloxy)-3-mesityl-2-oxo-1-oxaspiro[4.5]dec-3-en-8-yl)oxy)-2-(tert-butyl)-4-oxo-6,9,12,15,18,21-hexaoxa-3-azatricosan-1-oyl)-4-hydroxy-N—((S)-1-(4-(4-methylthiazol-5-yl)phenyl)ethyl)pyrrolidine-2-carboxamide (90 mg, 78.85 μmol) in THE (2 mL) was added 10% Pd/C (10 mg) under N₂. The mixture was degassed, purged with H₂ (3×), and stirred at 40° C. under 15 psi H₂ (balloon) for 4 hours. The mixture was filtered, and the filtrate concentrated in vacuo. The residue was purified by prep-HPLC (column: Phenomenex Luna C18, 150×25 mm×10 m, mobile phase: [water(0.225% FA)-ACN], B %: 51-81, 10 min) to give (2S,4R)-1-((S)-2-(tert-butyl)-23-(((5s,8s)-4-hydroxy-3-mesityl-2-oxo-1-oxaspiro[4.5]dec-3-en-8-yl)oxy)-4-oxo-6,9,12,15,18,21-hexaoxa-3-azatricosan-1-oyl)-4-hydroxy-N—((S)-1-(4-(4-methylthiazol-5-yl)phenyl)ethyl)pyrrolidine-2-carboxamide (29.80 mg, 27.50 μmol, 34.87% yield, 97.0% purity) as a yellow gum. HNMR: CDCl₃, 400 MHz. δ 8.17-8.13 (m, 1H), 7.46-7.42 (m, 1H), 7.41-7.33 (m, 5H), 6.86 (d, J=4.8 Hz, 2H), 5.10-5.02 (m, 1H), 4.80-4.74 (m, 1H), 4.71-4.65 (m, 1H), 4.56-4.51 (m, 1H), 4.45-4.40 (m, 1H), 4.08-3.95 (m, 3H), 3.71-3.62 (m, 24H), 3.58-3.53 (m, 1H), 3.51-3.44 (m, 1H), 2.51-2.41 (m, 4H), 2.25 (s, 3H), 2.14 (s, 6H), 2.10-2.01 (m, 5H), 1.86-1.81 (m, 4H), 1.47 (d, J=6.8 Hz, 3H), 1.05 (s, 9H). LCMS: RT=2.770 min, m/z 1051.5 [M+H]⁺.

### Example A-8. Synthesis of (2S,4R)-1-((S)-2-(tert-butyl)-23-(((5R,8R)-4-hydroxy-3-mesityl-2-oxo-1-oxaspiro[4.5]dec-3-en-8-yl)oxy)-4-oxo-6,9,12,15,18,21-hexaoxa-3-azatricosanoyl)-4-hydroxy-N—((S)-1-(4-(4-methylthiazol-5-yl)phenyl)ethyl)pyrrolidine-2-carboxamide

### A. Step 1

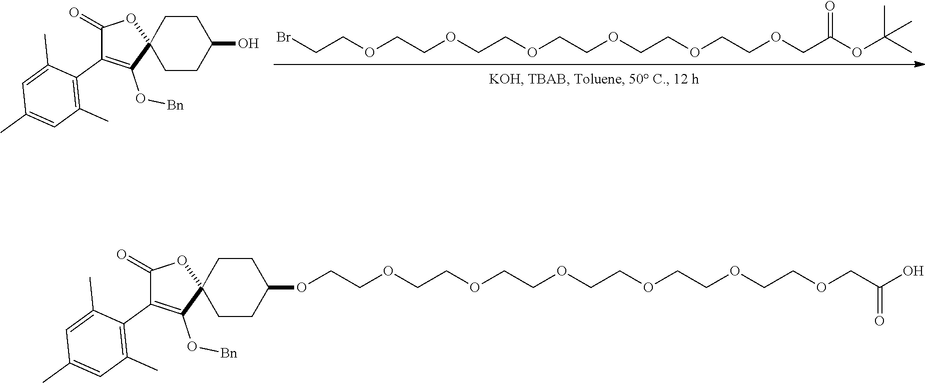

To a mixture of (5r,8r)-4-(benzyloxy)-8-hydroxy-3-mesityl-1-oxaspiro[4.5]dec-3-en-2-one (300.00 mg, 764.36 μmol; prepared using general methods described herein for the preparation of (5s,8s)-4-(benzyloxy)-8-hydroxy-3-mesityl-1-oxaspiro[4.5]dec-3-en-2-one), tert-butyl 2-[2-[2-[2-[2-[2-(2-bromoethoxy)ethoxy]ethoxy]ethoxy]ethoxy]ethoxy]acetate (526.68 mg, 1.15 mmol), and KOH (214.44 mg, 3.82 mmol) in toluene (10 mL) was added TBAB (98.56 mg, 305.74 μmol) at 25° C. The mixture was stirred at 50° C. for 12 hours, diluted with water (40 mL) and acidified to pH 3-4 by addition of 2 M aqueous HCl. The mixture was extracted with EtOAc (40 mL). The organic phase was washed with brine (40 mL×2), dried over anhydrous Na₂SO₄, filtered, and concentrated in vacuo. The residue was purified by flash chromatography (silica gel, gradient elution from 0 to 30% MeOH in DCM) to afford 20-(((5r,8r)-4-(benzyloxy)-3-mesityl-2-oxo-1-oxaspiro[4.5]dec-3-en-8-yl)oxy)-3,6,9,12,15,18-hexaoxaicosan-1-oic acid (38 mg, 53.16 μmol, 6.95% yield) as a yellow oil. LCMS: RT=0.997 min, m/z 715.6 [M+H]⁺.

### B. Step 2

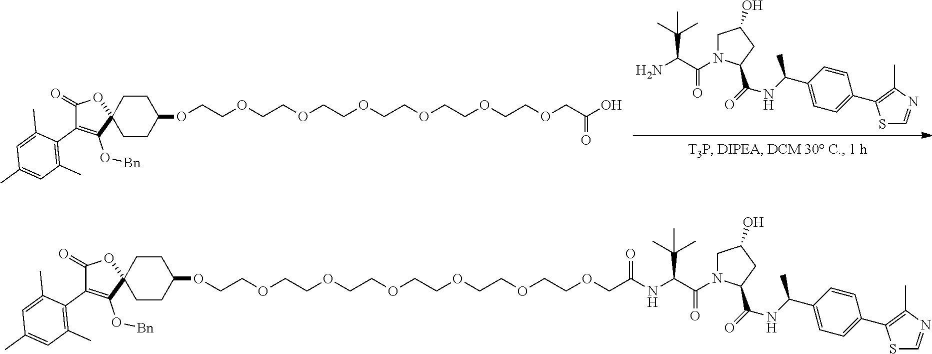

To a mixture of 20-(((5r,8r)-4-(benzyloxy)-3-mesityl-2-oxo-1-oxaspiro[4.5]dec-3-en-8-yl)oxy)-3,6,9,12,15,18-hexaoxaicosan-1-oic acid (38.00 mg, 53.16 μmol), (2S,4R)-1-[(2S)-2-amino-3,3-dimethyl-butanoyl]-4-hydroxy-N-[(1S)-1-[4-(4-methylthiazol-5-yl)phenyl]ethyl]pyrrolidine-2-carboxamide (38.36 mg, 79.74 μmol, HCl salt) and DIPEA (27.48 mg, 212.64 μmol, 37.04 μL) in DCM (2 mL) was added 50% T₃P (50.74 mg, 79.74 μmol, 47.42 μL). The mixture was stirred at 30° C. for 1 hour under N₂, diluted with 0.1 M aqueous HCl (20 mL), and extracted with DCM (20 mL). The organic phase was washed with brine (20 mL×2), dried over anhydrous Na₂SO₄, filtered and concentrated in vacuo to give (2S,4R)-1-((S)-23-(((5r,8r)-4-(benzyloxy)-3-mesityl-2-oxo-1-oxaspiro[4.5]dec-3-en-8-yl)oxy)-2-(tert-butyl)-4-oxo-6,9,12,15,18,21-hexaoxa-3-azatricosan-1-oyl)-4-hydroxy-N—((S)-1-(4-(4-methylthiazol-5-yl)phenyl)ethyl)pyrrolidine-2-carboxamide (65 mg) as a yellow oil, which was used in the next step without further purification. LCMS: RT=1.051 min, m/z 1141.8 [M+H]⁺.

### C. Step 3

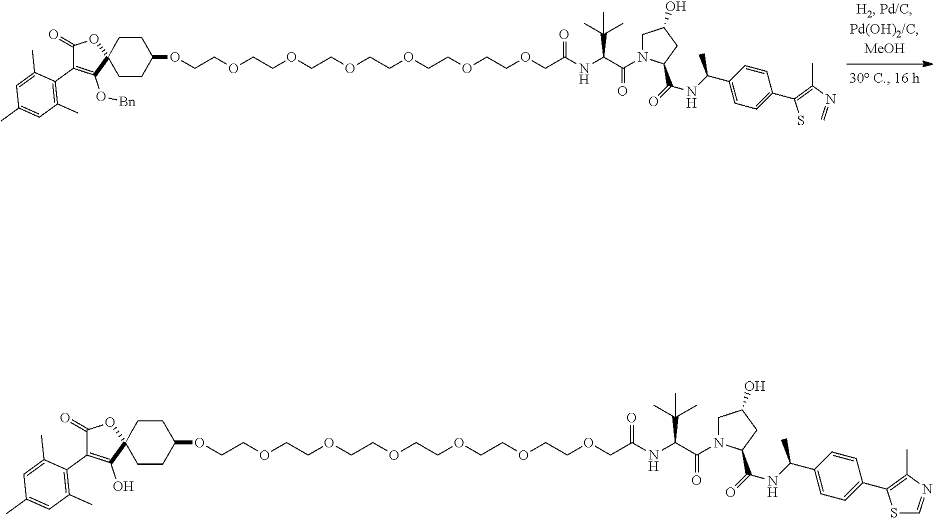

To a solution of (2S,4R)-1-((S)-23-(((5r,8r)-4-(benzyloxy)-3-mesityl-2-oxo-1-oxaspiro[4.5]dec-3-en-8-yl)oxy)-2-(tert-butyl)-4-oxo-6,9,12,15,18,21-hexaoxa-3-azatricosan-1-oyl)-4-hydroxy-N—((S)-1-(4-(4-methylthiazol-5-yl)phenyl)ethyl)pyrrolidine-2-carboxamide (65.00 mg, 56.95 μmol) in MeOH (2 mL) was added 10% Pd/C (10 mg) under N₂. The mixture was degassed, and purged with H₂ (3×), and stirred at 30° C. under 15 psi H₂ (balloon) for 1 hour. LCMS indicated that substantial starting material remained. The mixture was treated with 20% Pd(OH)₂ (10 mg) and subjected to 15 psi H₂ as described above for an additional 15 hours. The mixture was filtered, concentrated to dryness in vacuo, and the residue purified by prep-HPLC (column: Phenomenex Luna C18, 150×25 mm×10 μm, mobile phase: [water(0.225% FA)-ACN], B %: 48-78, 10 min) to give (2S,4R)-1-((S)-2-(tert-butyl)-23-(((5R,8R)-4-hydroxy-3-mesityl-2-oxo-1-oxaspiro[4.5]dec-3-en-8-yl)oxy)-4-oxo-6,9,12,15,18,21-hexaoxa-3-azatricosan-1-oyl)-4-hydroxy-N—((S)-1-(4-(4-methylthiazol-5-yl)phenyl)ethyl)pyrrolidine-2-carboxamide (16.45 mg, 15.19 μmol, 26.68% yield, 97.1% purity) as a brown gum. HNMR: CDCl₃, 400 MHz. δ 8.53 (s, 1H), 7.51-7.30 (m, 6H), 6.84 (s, 2H), 5.12-5.02 (m, 1H), 4.76-4.69 (m, 1H), 4.57-5.41 (m, 1H), 4.50-4.45 (m, 1H), 4.13-3.93 (m, 3H), 3.72-3.55 (m, 22H), 3.52-3.42 (m, 4H), 2.57-2.49 (m, 4H), 2.45-2.35 (m, 2H), 2.24 (s, 3H), 2.16 (s, 6H), 2.08-2.02 (m, 5H), 1.59-1.51 (m, 2H), 1.50-1.45 (m, 3H), 1.06 (s, 9H). LCMS: RT=3.239 min, m/z 1051.4 [M+H]⁺.

### Example A-9: Synthesis of (2S,4R)-4-hydroxy-1-((S)-2-(2-(2-(2-(4-(((5S,8S)-4-hydroxy-3-mesityl-2-oxo-1-oxaspiro[4.5]dec-3-en-8-yl)oxy)piperidin-1-yl)ethoxy)ethoxy)acetamido)-3,3-dimethylbutanoyl)-N—((S)-1-(4-(4-methylthiazol-5-yl)phenyl)ethyl)pyrrolidine-2-carboxamide

### A. Step 1

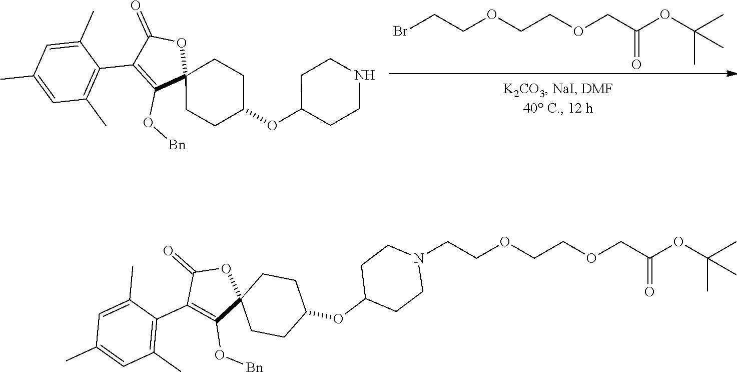

To a solution of (5s,8s)-4-(benzyloxy)-3-mesityl-8-(piperidin-4-yloxy)-1-oxaspiro[4.5]dec-3-en-2-one (220 mg, 373.11 μmol, crude, TFA salt; see Example 11, Step 5) and tert-butyl 2-[2-(2-bromoethoxy)ethoxy]acetate (158.47 mg, 559.66 μmol) in DMF (4 mL) were added NaI (22.37 mg, 149.24 μmol) and K₂CO₃ (154.70 mg, 1.12 mmol). The mixture was stirred at 40° C. for 12 hours, diluted with H₂O (20 mL), and extracted with EtOAc (20 mL×3). The combined organic layers were washed with brine (20 mL), dried over anhydrous Na₂SO₄, filtered, and concentrated at reduced pressure. The residue was purified by prep-TLC (silica gel, 10:1 DCM:MeOH) to give tert-butyl 2-(2-(2-(4-(((5s,8s)-4-(benzyloxy)-3-mesityl-2-oxo-1-oxaspiro[4.5]dec-3-en-8-yl)oxy)piperidin-1-yl)ethoxy)ethoxy)acetate (120 mg, 177.03 μmol, 47.45% yield) as a light-yellow gum. LCMS: RT=0.948 min, m/z 678.3 [M+H]⁺.

### B. Step 2

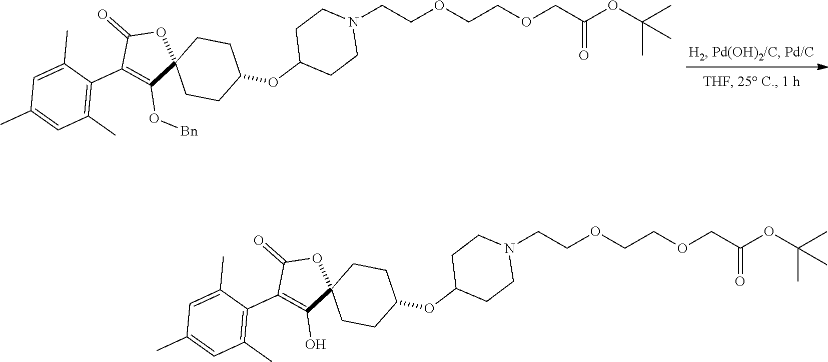

To a solution of tert-butyl 2-(2-(2-(4-(((5s,8s)-4-(benzyloxy)-3-mesityl-2-oxo-1-oxaspiro[4.5]dec-3-en-8-yl)oxy)piperidin-1-yl)ethoxy)ethoxy)acetate (120 mg, 177.03 μmol) in THF (5 mL) were added 20% Pd/C (50 mg) and 20% Pd(OH)₂/C (50 mg) under N₂. The mixture was degassed, purged with H₂ (3×), and stirred at 25° C. for 1 hour under 15 psi H₂ (balloon). The reaction mixture was filtered, and the filtrate was concentrated under reduced pressure to give tert-butyl 2-(2-(2-(4-(((5s,8s)-4-hydroxy-3-mesityl-2-oxo-1-oxaspiro[4.5]dec-3-en-8-yl)oxy)piperidin-1-yl)ethoxy)ethoxy)acetate (110 mg) as a light-yellow gum, which was used in the next step without further purification. LCMS: RT=0.864 min, m/z 588.5 [M+H]⁺.

### C. Step 3

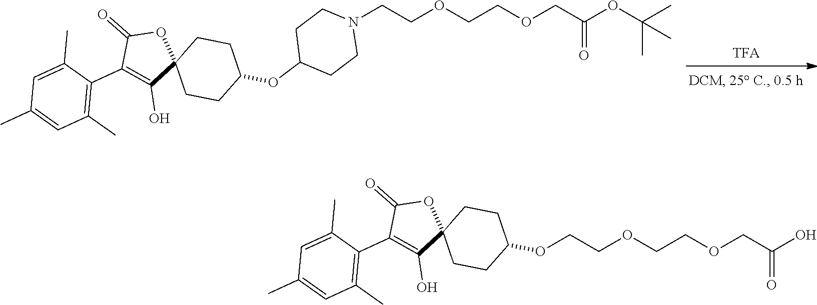

To a solution of tert-butyl 2-(2-(2-(4-(((5s,8s)-4-hydroxy-3-mesityl-2-oxo-1-oxaspiro[4.5]dec-3-en-8-yl)oxy)piperidin-1-yl)ethoxy)ethoxy)acetate (90 mg, 153.13 μmol, crude) in DCM (4 mL) was added TFA (770.00 mg, 6.75 mmol, 0.5 mL). The mixture stirred at 25° C. for 0.5 hours and concentrated under reduced pressure to afford 2-(2-(2-(4-(((5s,8s)-4-hydroxy-3-mesityl-2-oxo-1-oxaspiro[4.5]dec-3-en-8-yl)oxy)piperidin-1-yl)ethoxy)ethoxy)acetic acid (80 mg, crude) as a light-yellow gum, which was used in the next step without further purification. LCMS: RT=0.780 min, m/z 532.2 [M+H]⁺.

### D. Step 4

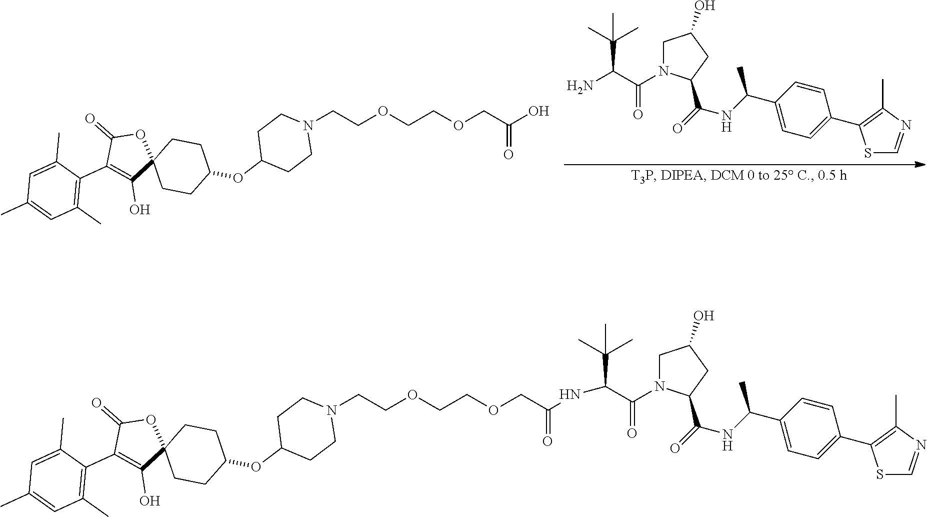

To a solution of 2-(2-(2-(4-(((5s,8s)-4-hydroxy-3-mesityl-2-oxo-1-oxaspiro[4.5]dec-3-en-8-yl)oxy)-piperidin-1-yl)ethoxy)ethoxy)acetic acid (80 mg, 150.48 μmol, crude product) and (2S,4R)-1-((S)-2-amino-3,3-dimethylbutanoyl)-4-hydroxy-N—((S)-1-(4-(4-methylthiazol-5-yl)phenyl)ethyl)pyrrolidine-2-carboxamide (86.87 mg, 195.38 μmol) in DCM (3 mL) were added DIPEA (58.34 mg, 451.44 μmol, 78.63 μL) and 50% T₃P (143.64 mg, 225.72 μmol, 134.24 μL) at 0° C. Then the mixture was stirred at 25° C. for 0.5 hour, diluted with H₂O (15 mL), and extracted with DCM (20 mL×3). The combined organic layers were washed with brine (10 mL), dried over with Na₂SO₄, filtered and concentrated under reduced pressure to give a residue. The residue was purified by prep-HPLC (column: Phenomenex Luna C18, 150×25 mm×10 μm, mobile phase: [water (0.225% FA)-ACN], B %: 21-51, 10 min) to give (2S,4R)-4-hydroxy-1-((S)-2-(2-(2-(2-(4-(((5s,8s)-4-hydroxy-3-mesityl-2-oxo-1-oxaspiro[4.5]dec-3-en-8-yl)oxy)piperidin-1-yl)ethoxy)ethoxy)acetamido)-3,3-dimethylbutanoyl)-N—((S)-1-(4-(4-methylthiazol-5-yl)phenyl)ethyl)-pyrrolidine-2-carboxamide (49.31 mg, 49.10 μmol, 32.63% yield, 99.9% purity, formic acid salt) as a white solid. HNMR: DMSO-d₆, 400 MHz δ 8.97 (s, 1H), 8.45 (d, J=7.6 Hz, 1H), 8.13 (s, 1H), 7.44-7.35 (m, 5H), 6.72 (s, 2H), 4.93-4.86 (m, 1H), 4.55 (d, J=9.2 Hz, 1H), 4.46-4.41 (m, 1H), 4.28 (s, 1H), 3.99-3.93 (m, 2H), 3.66-3.59 (m, 10H), 3.06-3.0 m, 2H), 2.93-2.87 (m, 2H), 2.72-2.62 (m, 2H), 2.45 (s, 3H), 2.18 (s, 3H), 2.07-2.02 (m, 7H), 1.90-1.84 (m, 4H), 1.82-1.73 (m, 3H), 1.64-1.54 (m, 2H), 1.49-1.43 (m, 4H), 1.37 (d, J=6.8 Hz, 3H), 0.94 (s, 9H). LCMS: RT=2.192 min, m/z 958.5 [M+H]⁺.

### Example A-10: Synthesis of (2S,4R)-4-hydroxy-1-((S)-2-(2-(2-(2-(4-(((5R,8R)-4-hydroxy-3-mesityl-2-oxo-1-oxaspiro[4.5]dec-3-en-8-yl)oxy)piperidin-1-yl)ethoxy)ethoxy)acetamido)-3,3-dimethylbutanoyl)-N—((S)-1-(4-(4-methylthiazol-5-yl)phenyl)ethyl)pyrrolidine-2-carboxamide

### A. Step 1

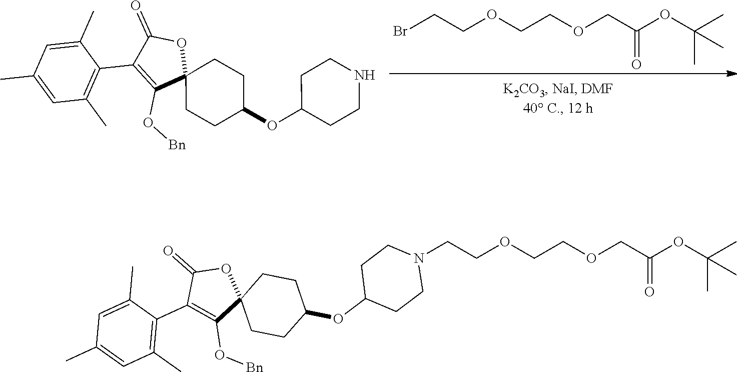

To a solution of (5r,8r)-4-(benzyloxy)-3-mesityl-8-(piperidin-4-yloxy)-1-oxaspiro[4.5]dec-3-en-2-one (250 mg, 423.99 μmol, crude, TFA salt; prepared from (5r,8r)-4-(benzyloxy)-8-hydroxy-3-mesityl-1-oxaspiro[4.5]dec-3-en-2-one using the general methods described in Example 11) and tert-butyl 2-[2-(2-bromoethoxy)ethoxy]acetate (180.08 mg, 635.98 μmol) in DMF (4 mL) were added NaI (25.42 mg, 169.59 μmol) and K₂CO₃ (175.80 mg, 1.27 mmol). The mixture was stirred at 40° C. for 12 hours, diluted with H₂O (20 mL), and extracted with EtOAc (20 mL×3). The combined organic layers were washed with brine (20 mL), dried over with Na₂SO₄, filtered, and concentrated to dryness at reduced pressure. The residue was purified by column chromatography (silica gel, gradient elution from 3:1 to 0:1 petroleum ether/EtOAc) to give tert-butyl 2-(2-(2-(4-(((5r,8r)-4-(benzyloxy)-3-mesityl-2-oxo-1-oxaspiro[4.5]dec-3-en-8-yl)oxy)-piperidin-1-yl)ethoxy)ethoxy)acetate (300 mg) as a light-yellow oil. LCMS: RT=0.971 min, m/z 678.4 [M+H]⁺.

### B. Step 2

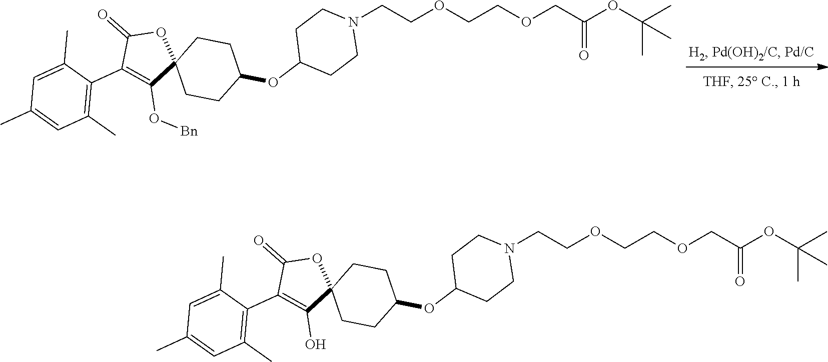

To a solution of tert-butyl 2-(2-(2-(4-(((5r,8r)-4-(benzyloxy)-3-mesityl-2-oxo-1-oxaspiro[4.5]dec-3-en-8-yl)oxy)piperidin-1-yl)ethoxy)ethoxy)acetate (300 mg, 442.57 μmol, crude) in THF (10 mL) were added 20% Pd/C (0.1 g) and 20% Pd(OH)₂ (0.1 g) under N₂. The mixture was degassed and purged with H₂ (3×). The mixture was stirred at 25° C. for 1 hour under 15 psi H₂ (balloon). The reaction mixture was filtered, and the filtrate was concentrated under reduced pressure to give tert-butyl 2-(2-(2-(4-(((5r,8r)-4-hydroxy-3-mesityl-2-oxo-1-oxaspiro[4.5]dec-3-en-8-yl)oxy)piperidin-1-yl)ethoxy)ethoxy)acetate (300 mg, crude) as a light-yellow oil, which was used in the next step without further purification. LCMS: RT=0.851 min, m/z 588.2 [M+H]⁺.

### C. Step 3

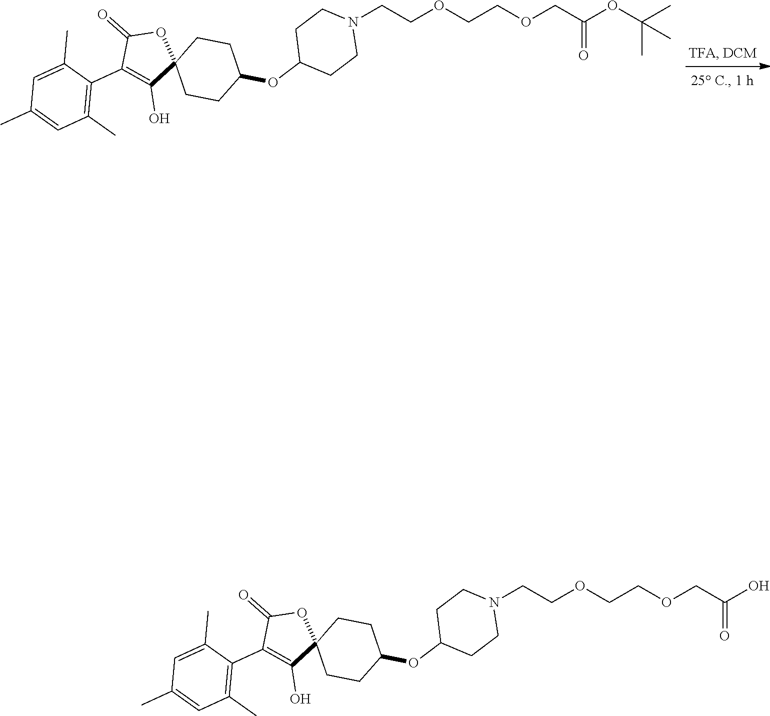

To a solution of tert-butyl 2-(2-(2-(4-(((5r,8r)-4-hydroxy-3-mesityl-2-oxo-1-oxaspiro[4.5]dec-3-en-8-yl)oxy)piperidin-1l-yl)ethoxy)ethoxy)acetate (300 mg, 510.43 μmol, crude) in DCM (10 mL) was added TFA (3.08 g, 27.01 mmol, 2 mL). The mixture was stirred at 25° C. for 1 hour and concentrated under reduced pressure to afford 2-(2-(2-(4-(((5r,8r)-4-hydroxy-3-mesityl-2-oxo-1-oxaspiro[4.5]dec-3-en-8-yl)oxy)piperidin-1-yl)ethoxy)ethoxy)acetic acid (280 mg) as a light-yellow oil, which was used in the next step without further purification. LCMS: RT=0.565 min, m/z 532.3 [M+H]⁺.

### D. Step 4

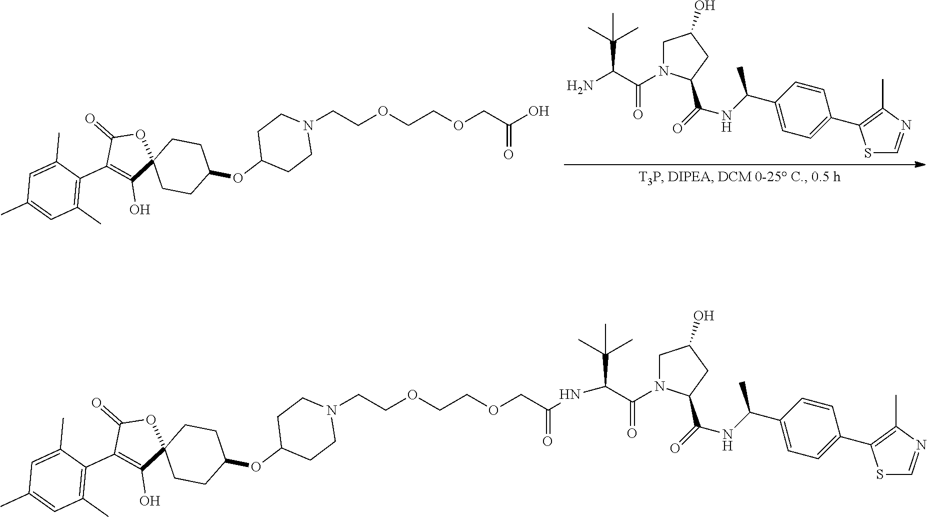

To a solution of 2-(2-(2-(4-(((5r,8r)-4-hydroxy-3-mesityl-2-oxo-1-oxaspiro[4.5]dec-3-en-8-yl)oxy)piperidin-1-yl)ethoxy)ethoxy)acetic acid (230 mg, 432.63 μmol, crude) and (2S,4R)-1-((S)-2-amino-3,3-dimethylbutanoyl)-4-hydroxy-N—((S)-1-(4-(4-methylthiazol-5-yl)phenyl)ethyl)pyrrolidine-2-carboxamide (250.04 mg, 562.41 μmol) in DCM (5 mL) at 0° C. were added DIPEA (167.74 mg, 1.30 mmol, 226.06 μL) and 50% T₃P (412.96 mg, 648.94 μmol, 385.94 μL). The mixture was stirred at 25° C. for 0.5 hour, diluted with H₂O (15 mL), and extracted with DCM (20 mL×3). The combined organic layers were washed with brine (10 mL), dried over with Na₂SO₄, filtered, and concentrated to dryness under reduced pressure. The residue was purified by prep-HPLC (column: Phenomenex Luna C18, 150×25 mm×10 rm, mobile phase: [water (0.225% FA)-ACN], B %: 22-52, 10 min) to afford (2S,4R)-4-hydroxy-1-((S)-2-(2-(2-(2-(4-(((5r,8r)-4-hydroxy-3-mesityl-2-oxo-1-oxaspiro[4.5]dec-3-en-8-yl)oxy)piperidin-1-yl)ethoxy)ethoxy)acetamido)-3,3-dimethylbutanoyl)-N—((S)-1-(4-(4-methylthiazol-5-yl)phenyl)ethyl)pyrrolidine-2-carboxamide (131.98 mg, 132.64 μmol, 30.66% yield, 96.3% purity) as a white solid. HNMR: DMSO-d₆, 400 MHz. δ 8.98 (s, 1H), 8.47 (d, J=7.6 Hz, 1H), 8.12 (s, 1H), 7.45-7.39 (m, 3H), 7.37-7.34 (m, 2H), 6.75 (s, 2H), 4.93-4.85 (m, 1H), 4.56 (d, J=9.6 Hz, 1H), 4.46-4.41 (m, 1H), 4.28-4.24 (m 1H), 3.98 (s, 2H), 3.75-3.55 (m, 10H), 3.11-3.02 (m, 2H), 2.88-2.71 (m, 4H), 2.45 (s, 3H), 2.19 (s, 3H), 2.09-2.03 (m, 9H), 1.88 (m, 2H), 1.80-1.63 (m, 7H), 1.36 (d, J=6.8 Hz, 3H), 1.25 (d, J=12.0 Hz, 2H), 0.94 (s, 9H). LCMS: RT=2.218 min, m/z 959.5 [M+H]⁺.

### Example A-11: Synthesis of (2S,4R)-1-((S)-2-(tert-butyl)-14-(4-(((5S,8S)-4-hydroxy-3-mesityl-2-oxo-1-oxaspiro[4.5]dec-3-en-8-yl)oxy)piperidin-1-yl)-4-oxo-6,9,12-trioxa-3-azatetradecanoyl)-4-hydroxy-N—((S)-1-(4-(4-methylthiazol-5-yl)phenyl)ethyl)pyrrolidine-2-carboxamide

### A. Step 1

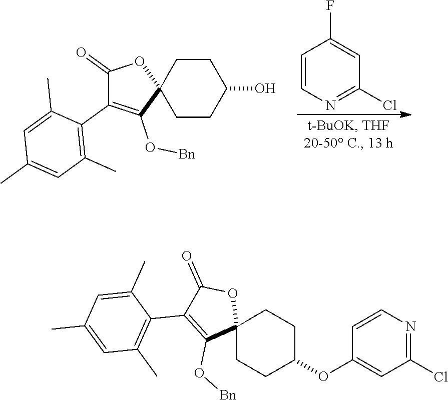

To a stirred solution of (5s,8s)-4-(benzyloxy)-8-hydroxy-3-mesityl-1-oxaspiro[4.5]dec-3-en-2-one (1 g, 2.55 mmol; see Example 7, Step 10) in THE (15 mL) was added t-BuOK (1 mol/L, 2.80 mL) at 25° C. After 1 hour, 2-chloro-4-fluoro-pyridine (402.16 mg, 3.06 mmol) was added. The mixture was stirred at 50° C. for 12 hours, quenched with saturated aqueous NH₄Cl aqueous (10 mL), and diluted with EtOAc (20 mL) and H₂O (5 mL). The aqueous phase was further extracted with EtOAc (10 mL×3). The combined organic layers were washed with brine (10 mL×3), dried over Na₂SO₄, filtered, and concentrated in vacuo. The residue was purified by column chromatography (silica gel, gradient elution from 50 to 100% EtOAc in petroleum ether) to afford (5s,8s)-4-(benzyloxy)-8-((2-chloropyridin-4-yl)oxy)-3-mesityl-1-oxaspiro-[4.5]dec-3-en-2-one (4.42 g) as a white solid. HNMR CDCl₃, 400 MHz. δ 8.18 (d, J=5.6 Hz, 1H), 7.29-7.37 (m, 3H), 7.00-7.06 (m, 2H), 6.90 (s, 2H), 6.82-6.86 (m, 1H), 6.73-6.78 (m, 1H), 4.80 (s, 2H), 4.33-4.43 (m, 1H), 2.31 (s, 3H), 2.03-2.20 (m, 12H), 1.87-1.96 (m, 2H). LCMS: RT=1.103 min, m/z 504.2 [M+H]⁺.

### B. Step 2

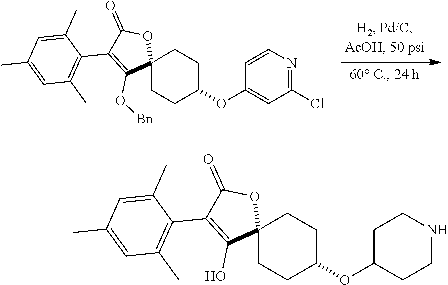 [SMILES: Cc1cc(C)c(C2=C(OCc3ccccc3)[C@]3(CC[C@H](Oc4ccnc(Cl)c4)CC3)OC2=O)c(C)c1 ; Cc1cc(C)c(C2=C(O)[C@]3(CC[C@H](OC4CCNCC4)CC3)OC2=O)c(C)c1]

To a mixture of (5s,8s)-4-(benzyloxy)-8-((2-chloropyridin-4-yl)oxy)-3-mesityl-1-oxaspiro[4.5]dec-3-en-2-one (4 g, 7.94 mmol) in AcOH (100 mL) was added 10% Pd/C (1 g). The mixture was stirred at 60° C. for 24 hours under H₂ (50 psi). The mixture was filtered and the filtrate concentrated in vacuo to afford (5s,8s)-4-hydroxy-3-mesityl-8-(piperidin-4-yloxy)-1-oxaspiro[4.5]dec-3-en-2-one (3.5 g, crude, AcOH salt) as an off-white solid which was used in the next without further purification. HNMR: DMSO-d₆, 400 MHz. δ 8.92-9.09 (m, 1H), 6.83 (s, 2H), 3.65-3.80 (m, 1H), 3.00-3.15 (m, 2H), 2.80-2.97 (m, 2H), 2.22 (s, 3H), 1.85-2.10 (m, 14H), 1.43-1.69 (m, 6H). LCMS: RT=0.781 min, m/z 386.4 [M+H]⁺.

### C. Step 3

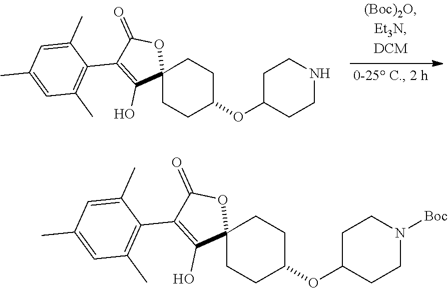

To a stirred mixture of (5s,8s)-4-hydroxy-3-mesityl-8-(piperidin-4-yloxy)-1-oxaspiro[4.5]dec-3-en-2-one (3.25 g, 7.29 mmol, AcOH salt) and (Boc)₂ O (1.91 g, 8.75 mmol, 2.01 mL) in DCM (60 mL) at 0° C. was added Et3N (1.48 g, 14.59 mmol, 2.03 mL). The reaction mixture was stirred at 25° C. for 2 hours, diluted with DCM (60 mL) and H₂O (30 mL). The mixture was extracted with DCM (20 mL×3). The combined organic layers were washed with brine (60 mL×3), dried over Na₂SO₄, filtered, and concentrated in vacuo to afford tert-butyl 4-(((5s,8s)-4-hydroxy-3-mesityl-2-oxo-1-oxaspiro[4.5]dec-3-en-8-yl)oxy)piperidine-1-carboxylate (4.25 g, crude) as yellow oil, which was used in the next step without further purification. LCMS: RT=0.829 min, m/z 386.1 [M−Boc+H]⁺.

### D. Step 4

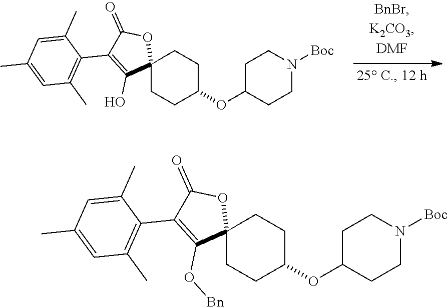 [SMILES: Cc1cc(C)c(C2=C(O)[C@]3(CC[C@H](OC4CCN(C(=O)OC(C)(C)C)CC4)CC3)OC2=O)c(C)c1 ; Cc1cc(C)c(C2=C(OCc3ccccc3)[C@]3(CC[C@H](OC4CCN(C(=O)OC(C)(C)C)CC4)CC3)OC2=O)c(C)c1]

To a stirred mixture of tert-butyl 4-(((5s,8s)-4-hydroxy-3-mesityl-2-oxo-1-oxaspiro[4.5]dec-3-en-8-yl)oxy)piperidine-1-carboxylate (4.25 g, 6.35 mmol, crude) and K₂CO₃ (1.75 g, 12.69 mmol) in DMF (30 mL) at 25° C. was added BnBr (1.41 g, 8.25 mmol, 979.72 μL). The mixture was stirred at 25° C. for 12 hours. The mixture was diluted with EtOAc (50 mL) and H₂O (30 mL) and extracted with EtOAc (10 mL×3). The combined organic layers were washed with brine (50 mL×3), dried over Na₂SO₄, filtered, and concentrated in vacuo. The residue was purified by column chromatography (silica gel, gradient elution from 30:1 to 8:1 petroleum ether:EtOAc) to afford tert-butyl 4-(((5s,8s)-4-(benzyloxy)-3-mesityl-2-oxo-1-oxaspiro[4.5]dec-3-en-8-yl)oxy)piperidine-1-carboxylate (2.5 g, 4.34 mmol, 68.44% yield) as colorless oil. HNMR: CDCl₃, 400 MHz. δ 7.28-7.33 (m, 3H), 6.99-7.04 (m, 2H), 6.89 (s, 2H), 4.76 (s, 2H), 3.75-3.85 (m, 2H), 3.58-3.64 (m, 1H), 3.42-3.48 (m, 1H), 3.04-3.11 (m, 2H), 2.29 (s, 3H), 2.10 (s, 6H), 1.96-2.01 (m, 4H), 1.77-1.85 (m, 6H), 1.49-1.57 (m, 2H), 1.45-1.47 (m, 9H). LCMS: RT=1.167 min, m/z 476.3 [M−Boc+H]⁺.

### E. Step 5

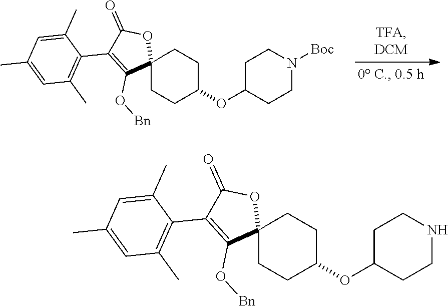 [SMILES: Cc1cc(C)c(C2=C(OCc3ccccc3)[C@]3(CC[C@H](OC4CCN(C(=O)OC(C)(C)C)CC4)CC3)OC2=O)c(C)c1 ; Cc1cc(C)c(C2=C(OCc3ccccc3)[C@]3(CC[C@H](OC4CCNCC4)CC3)OC2=O)c(C)c1]

A mixture of tert-butyl 4-(((5s,8s)-4-(benzyloxy)-3-mesityl-2-oxo-1-oxaspiro[4.5]dec-3-en-8-yl)oxy)-piperidine-1-carboxylate (2.4 g, 4.17 mmol) in DCM (80 mL) and TFA (15 mL) was stirred at 0° C. for 0.5 hours. The mixture was concentrated in vacuo to afford (5s,8s)-4-(benzyloxy)-3-mesityl-8-(piperidin-4-yloxy)-1-oxaspiro[4.5]dec-3-en-2-one (2.46 g, crude, TFA salt) as colorless oil, which was used in the next step without further purification. LCMS: RT=0.822 min, m/z 476.3 [M+H]⁺.

### F. Step 6

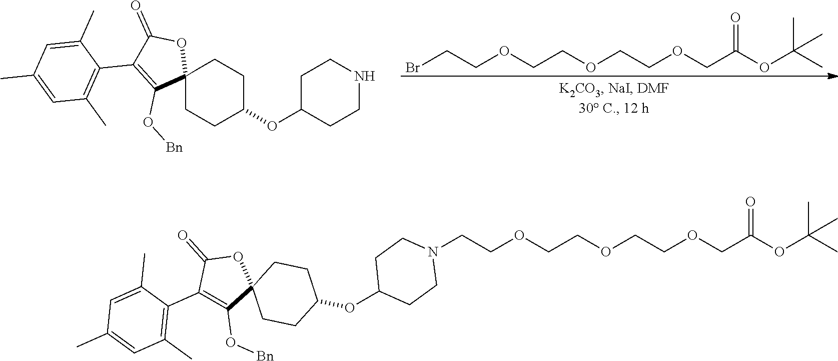 [SMILES: Cc1cc(C)c(C2=C(OCc3ccccc3)[C@]3(CC[C@H](OC4CCNCC4)CC3)OC2=O)c(C)c1 ; CC(C)(C)OC(=O)COCCOCCOCCBr ; Cc1cc(C)c(C2=C(OCc3ccccc3)[C@]3(CC[C@H](OC4CCN(CCOCCOCCOCC(=O)OC(C)(C)C)CC4)CC3)OC2=O)c(C)c1]

To a solution of (5s,8s)-4-(benzyloxy)-3-mesityl-8-(piperidin-4-yloxy)-1-oxaspiro[4.5]dec-3-en-2-one (260 mg, 440.95 μmol, TFA salt) and tert-butyl 2-[2-[2-(2-bromoethoxy)ethoxy]ethoxy]acetate (173.14 mg, 529.14 μmol) in DMF (6 mL) at 25° C. was added K₂CO₃ (121.88 mg, 881.89 μmol) and NaI (13.22 mg, 88.19 μmol). The mixture was stirred at 30° C. for 12 hours, diluted with EtOAc (12 mL) and H₂O (8 mL) and extracted with EtOAc (5 mL×3). The combined organic layers were washed with brine (10 mL×3), dried over Na₂SO₄, filtered, and concentrated in vacuo. The residue was purified by prep-TLC (silica gel, 10:1 DCM:MeOH) to afford tert-butyl 2-(2-(2-(2-(4-(((5s,8s)-4-(benzyloxy)-3-mesityl-2-oxo-1-oxaspiro[4.5]dec-3-en-8-yl)oxy)piperidin-1-yl)ethoxy)ethoxy)ethoxy)acetate (250 mg, 346.30 μmol, 78.54% yield) as yellow oil. LCMS: RT=0.957 min, m/z 722.6 [M+H]⁺.

### G. Step 7

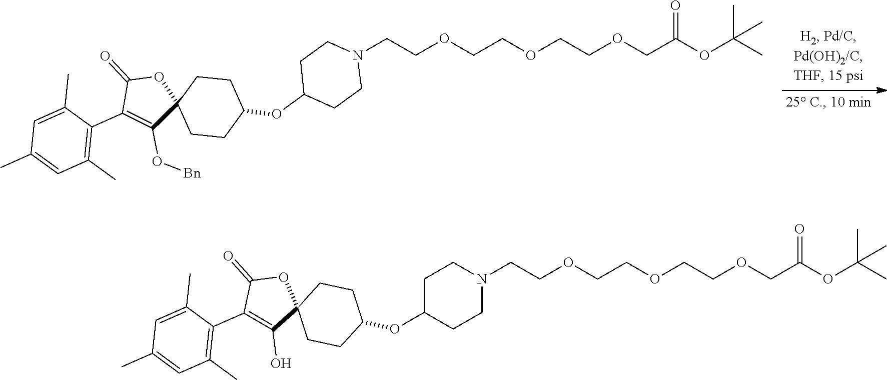

To a mixture of tert-butyl 2-(2-(2-(2-(4-(((5s,8s)-4-(benzyloxy)-3-mesityl-2-oxo-1-oxaspiro[4.5]dec-3-en-8-yl)oxy)piperidin-1-yl)ethoxy)ethoxy)ethoxy)acetate (250 mg, 346.30 μmol) in THF (5 mL) were added 10% Pd/C (40 mg) and 20% Pd(OH)₂/C (40 mg). The reaction mixture was stirred at 25° C. for 10 mins under 15 psi H₂. The mixture was filtered and the filtrate concentrated in vacuo to afford tert-butyl 2-(2-(2-(2-(4-(((5s,8s)-4-hydroxy-3-mesityl-2-oxo-1-oxaspiro[4.5]dec-3-en-8-yl)oxy)piperidin-1-yl)ethoxy)ethoxy)-ethoxy)acetate (200 mg, 316.56 μmol, 91.41% yield) as yellow oil which was used in the next step without further purification. LCMS: RT=0.876 min, m/z 632.4 [M+H]⁺.

### H. Step 8

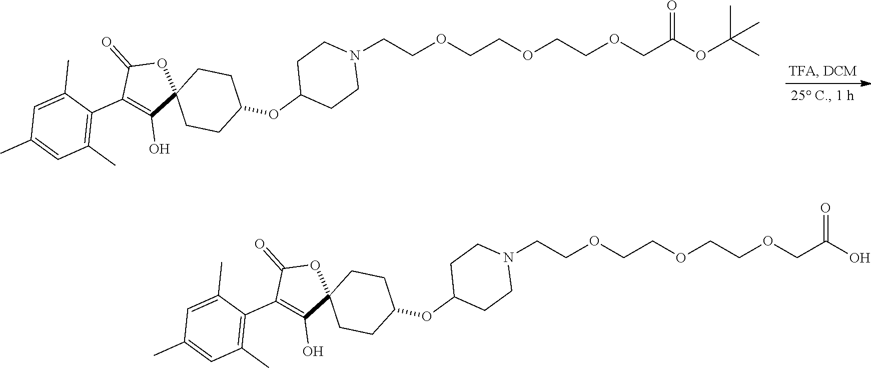

A mixture of tert-butyl 2-(2-(2-(2-(4-(((5s,8s)-4-hydroxy-3-mesityl-2-oxo-1-oxaspiro[4.5]dec-3-en-8-yl)oxy)piperidin-1-yl)ethoxy)ethoxy)ethoxy)acetate (200 mg, 316.56 μmol) in TFA (1 mL) and DCM (3 mL) was stirred at 25° C. for 1 hour and then concentrated in vacuo to afford 2-(2-(2-(2-(4-(((5s,8s)-4-hydroxy-3-mesityl-2-oxo-1-oxaspiro[4.5]dec-3-en-8-yl)oxy)piperidin-1-yl)ethoxy)ethoxy)ethoxy)acetic acid (180 mg, crude) as yellow oil which was used to the next step without further purification. LCMS: RT=0.694 min, m/z 576.3 [M+H]⁺.

### I. Step 9

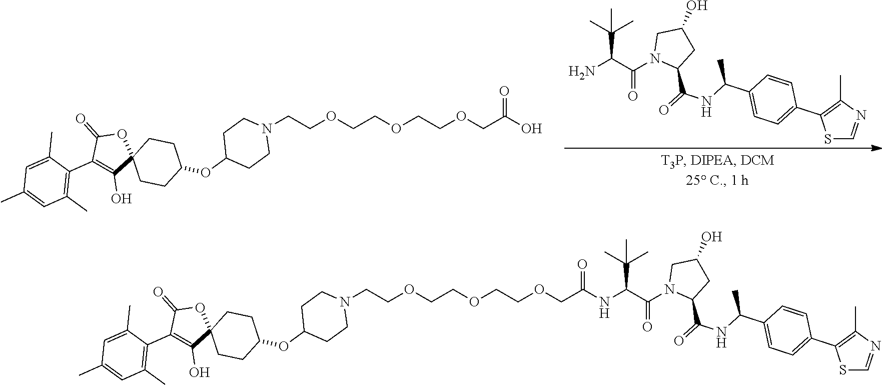 [SMILES: Cc1cc(C)c(C2=C(O)[C@]3(CC[C@H](OC4CCN(CCOCCOCCOCC(=O)O)CC4)CC3)OC2=O)c(C)c1 ; Cc1ncsc1-c1ccc([C@H](C)NC(=O)[C@@H]2C[C@@H](O)CN2C(=O)[C@@H](N)C(C)(C)C)cc1 ; Cc1cc(C)c(C2=C(O)[C@]3(CC[C@H](OC4CCN(CCOCCOCCOCC(=O)N[C@H](C(=O)N5C[C@H](O)C[C@H]5C(=O)N[C@@H](C)c5ccc(-c6scnc6C)cc5)C(C)(C)C)CC4)CC3)OC2=O)c(C)c1]

To a stirred solution of 2-(2-(2-(2-(4-(((5s,8s)-4-hydroxy-3-mesityl-2-oxo-1-oxaspiro[4.5]dec-3-en-8-yl)oxy)piperidin-1-yl)ethoxy)ethoxy)ethoxy)acetic acid (160 mg, 277.93 μmol) and (2S, 4R)-1-[(2S)-2-amino-3, 3-dimethyl-butanoyl]-4-hydroxy-N-[(1S)-1-[4-(4-methylthiazol-5-yl) phenyl]ethyl]pyrrolidine-2-carboxamide (173.81 mg, 361.31 μmol, 1.3 eq, HCl salt) in DCM (10 mL) at 25° C. was added DIPEA (143.68 mg, 1.11 mmol, 193.64 μL) and 50% T₃P (265.29 mg, 416.89 μmol, 247.94 μL). The mixture was stirred at 25° C. for 1 hour, diluted with DCM (10 mL) and H₂O (5 mL), and extracted with DCM (5 mL×3). The combined organic layers were washed with brine (10 mL×3), dried over Na₂SO₄, filtered, and concentrated in vacuo. The residue was purified by prep-HPLC twice (column: Unisil 3-100 C18 Ultra, 150×50 mm×3 m, mobile phase: [water (0.225% FA)-ACN], B %: 25-45, 10 min; column: Waters Xbridge 150×25 mm, 5 μm, mobile phase: [water (10 mM NH₄HCO₃)-ACN], B %: 23-53, 10 min) followed by prep-TLC (silica gel, 10:1 DCM:MeOH) to afford (2S,4R)-1-((S)-2-(tert-butyl)-14-(4-(((5s,8s)-4-hydroxy-3-mesityl-2-oxo-1-oxaspiro[4.5]dec-3-en-8-yl)oxy)piperidin-1-yl)-4-oxo-6,9,12-trioxa-3-azatetradecan-1-oyl)-4-hydroxy-N—((S)-1-(4-(4-methylthiazol-5-yl)phenyl)ethyl)pyrrolidine-2-carboxamide (87.91 mg, 87.71 μmol, 31.56% yield, 99.9% purity) as an off-white gum. HNMR: CDCl₃, 400 MHz. δ 8.66 (s, 1H), 7.60-7.54 (m, 1H), 7.39-7.31 (m, 5H), 6.82 (s, 2H), 5.07 (t, J=7.2 Hz, 1H), 4.69-4.60 (m, 2H), 4.44-4.35 (m, 1H), 4.02 (d, J=2.4 Hz, 2H), 3.94-3.84 (m, 1H), 3.71-3.50 (m, 13H), 3.40-3.32 (m, 1H), 3.00-2.89 (m, 2H), 2.74-2.64 (m, 2H), 2.52 (s, 3H), 2.22-2.21 (m, 3H), 2.16 (s, 6H), 2.11-2.08 (m, 1H), 1.97-1.81 (m, 8H), 1.80-1.67 (m, 7H), 1.46 (d, J=6.8 Hz, 3H), 1.04 (s, 9H). LCMS: RT=2.195 min, m/z 1002.5 [M+H]⁺.

### Example A-12: Synthesis of (2S,4R)-1-((S)-2-(tert-butyl)-14-(4-(((5R,8R)-4-hydroxy-3-mesityl-2-oxo-1-oxaspiro[4.5]dec-3-en-8-yl)oxy)piperidin-1-yl)-4-oxo-6,9,12-trioxa-3-azatetradecanoyl)-4-hydroxy-N—((S)-1-(4-(4-methylthiazol-5-yl)phenyl)ethyl)pyrrolidine-2-carboxamide

### A. Step 1

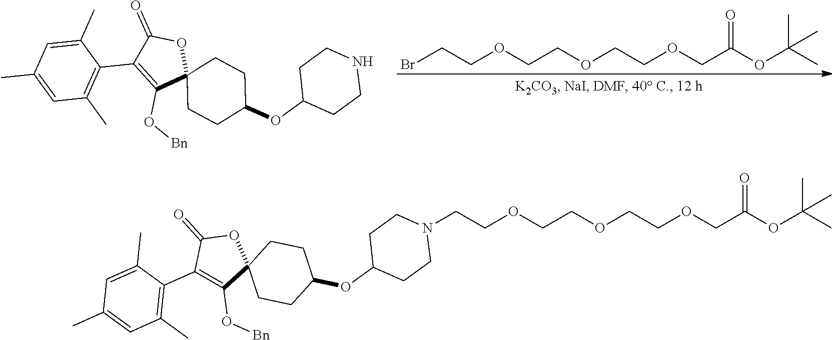

To a solution of (5r,8r)-4-(benzyloxy)-3-mesityl-8-(piperidin-4-yloxy)-1-oxaspiro[4.5]dec-3-en-2-one (247.95 mg, 420.51 μmol, TFA salt; prepared from (5r,8r)-4-(benzyloxy)-8-hydroxy-3-mesityl-1-oxaspiro[4.5]dec-3-en-2-one using the general methods described in Example 11) and tert-butyl 2-[2-[2-(2-bromoethoxy)ethoxy]ethoxy]acetate (206.39 mg, 630.76 μmol) in DMF (2 mL) were added K₂CO₃ (174.35 mg, 1.26 mmol) and NaI (63.03 mg, 420.51 μmol). The mixture was stirred at 40° C. for 12 hours, diluted with H₂O (20 mL) and extracted with EtOAc (60 mL). The combined organic layers were washed with brine (50 mL), dried over Na₂SO₄, filtered, and concentrated at reduced pressure. The residue was purified by flash chromatography (silica gel, gradient elution from 0 to 10% MeOH in DCM) to give tert-butyl 2-(2-(2-(2-(4-(((5r,8r)-4-(benzyloxy)-3-mesityl-2-oxo-1-oxaspiro[4.5]dec-3-en-8-yl)oxy)piperidin-1-yl)ethoxy)ethoxy)ethoxy)acetate (203 mg, 278.10 μmol, 66.14% yield, 98.9% purity) as an off-white gum. LCMS: RT=0.963 min, m/z 721.9 [M+H]⁺.

### B. Step 2

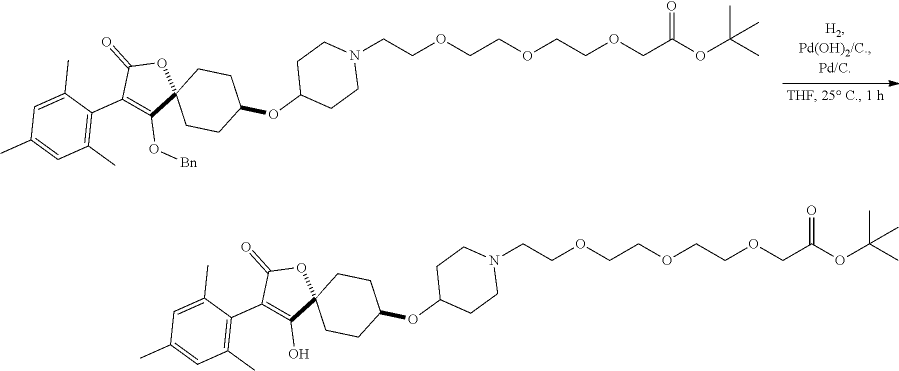

To a solution of tert-butyl 2-(2-(2-(2-(4-(((5r,8r)-4-(benzyloxy)-3-mesityl-2-oxo-1-oxaspiro[4.5]dec-3-en-8-yl)oxy)piperidin-1-yl)ethoxy)ethoxy)ethoxy)acetate (203 mg, 281.20 μmol) in THF (4 mL) was added 10% Pd/C (20 mg) and 20% Pd(OH)₂ (20 mg) under N₂. The mixture was degassed and purged with H₂ (3×), then stirred under 15 psi H₂ (balloon) at 25° C. for 1 hour. The mixture was filtered and concentrated under reduced pressure to give tert-butyl 2-(2-(2-(2-(4-(((5r,8r)-4-hydroxy-3-mesityl-2-oxo-1-oxaspiro[4.5]dec-3-en-8-yl)oxy)piperidin-1-yl)ethoxy)ethoxy)ethoxy)acetate (150 mg) as a light-yellow gum, which was used in the next step without further purification. LCMS: RT=0.864 min, m % z 631.8 [M+H]⁺.

### C. Step 3

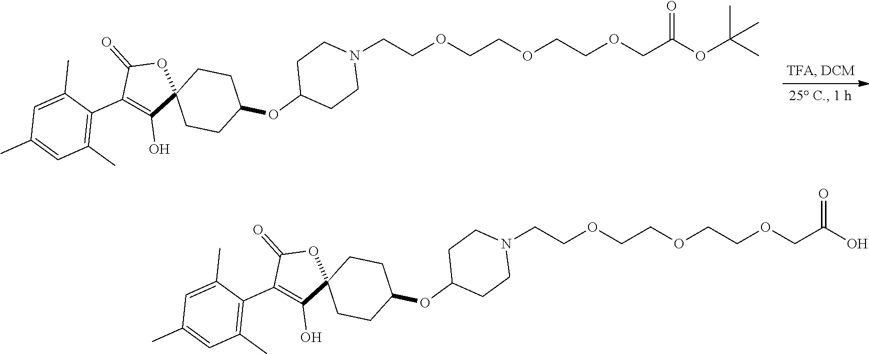

To a solution of tert-butyl 2-(2-(2-(2-(4-(((5r,8r)-4-hydroxy-3-mesityl-2-oxo-1-oxaspiro[4.5]dec-3-en-8-yl)oxy)piperidin-1-yl)ethoxy)ethoxy)ethoxy)acetate (150 mg, 237.42 μmol, crude) in DCM (1.5 mL) was added TFA (770.00 mg, 6.75 mmol, 0.5 mL). The mixture was stirred at 25° C. for 1 hour and evaporated to dryness. The residue was redissolved in DCM and again concentrated to dryness to afford 2-(2-(2-(2-(4-(((5r,8r)-4-hydroxy-3-mesityl-2-oxo-1-oxaspiro[4.5]dec-3-en-8-yl)oxy)piperidin-1-yl)ethoxy)ethoxy)ethoxy)acetic acid (204 mg, crude, TFA salt) as a light-yellow gum, which was used in the next step without further purification. LCMS: RT=0.799 min, m/z 575.3 [M+H]⁺.

### D. Step 4

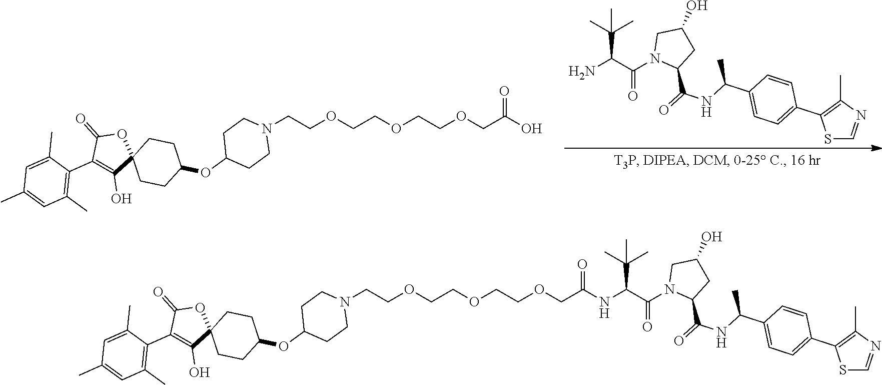 [SMILES: Cc1cc(C)c(C2=C(O)[C@]3(CC[C@@H](OC4CCN(CCOCCOCCOCC(=O)O)CC4)CC3)OC2=O)c(C)c1 ; Cc1ncsc1-c1ccc([C@H](C)NC(=O)[C@@H]2C[C@@H](O)CN2C(=O)[C@@H](N)C(C)(C)C)cc1 ; Cc1cc(C)c(C2=C(O)[C@]3(CC[C@@H](OC4CCN(CCOCCOCCOCC(=O)N[C@H](C(=O)N5C[C@H](O)C[C@H]5C(=O)N[C@@H](C)c5ccc(-c6scnc6C)cc5)C(C)(C)C)CC4)CC3)OC2=O)c(C)c1]

To a solution of 2-(2-(2-(2-(4-(((5r,8r)-4-hydroxy-3-mesityl-2-oxo-1-oxaspiro[4.5]dec-3-en-8-yl)oxy)piperidin-1-yl)ethoxy)ethoxy)ethoxy)acetic acid (204 mg, 295.78 μmol, TFA salt) and (2S,4R)-1-[(2S)-2-amino-3,3-dimethyl-butanoyl]-4-hydroxy-N-[(1S)-1-[4-(4-methylthiazol-5-yl)phenyl]ethyl]pyrrolidine-2-carboxamide (170.95 mg, 355.36 μmol, HCl salt) in DCM (2 mL) at 0° C. were added 50% T₃P (225.86 mg, 354.93 μmol, 211.09 μL) and DIPEA (191.13 mg, 1.48 mmol, 257.59 μL). The mixture was stirred at 25° C. for 16 hours, diluted with H₂O (20 mL) and extracted with DCM (80 mL). The combined organic layers were washed with brine (40 mL), dried over Na₂SO₄, and concentrated at reduced pressure. The residue was purified by prep-HPLC (column: Phenomenex Gemini-NX C18, 75×30 mm×3 μm, mobile phase: [water (0.225% FA)-ACN], B %: 25-55, 7 min) to give (2S,4R)-1-((S)-2-(tert-butyl)-14-(4-(((5r,8r)-4-hydroxy-3-mesityl-2-oxo-1-oxaspiro[4.5]dec-3-en-8-yl)oxy)piperidin-1-yl)-4-oxo-6,9,12-trioxa-3-azatetradecanoyl)-4-hydroxy-N—((S)-1-(4-(4-methylthiazol-5-yl)phenyl)ethyl)pyrrolidine-2-carboxamide (71.16 mg, 69.58 μmol, 23.52% yield, 98.0% purity) as a white solid. HNMR: DMSO-d₆, 400 MHz. δ 8.98 (s, 1H), 8.47 (d, J=7.6 Hz, 1H), 8.12 (s, 1H), 7.45-7.33 (m, 5H), 6.75 (s, 2H), 5.31-5.09 (m, 1H), 4.93-4.85 (m, 1H), 4.55 (d, J=9.6 Hz, 1H), 4.43 (t, J=8.0 Hz, 1H), 4.29-4.21 (m, 1H), 3.97 (s, 2H), 3.74-3.70 (m, 1H), 3.63-3.54 (m, 13H), 3.09-3.03 (m, 2H), 2.90-2.66 (m, 4H), 2.45 (s, 3H), 2.19 (s, 3H), 2.05 (s, 9H), 1.92-1.85 (m, 2H), 1.82-1.59 (m, 7H), 1.37 (d, J=6.8 Hz, 3H), 1.29-1.19 (m, 2H), 0.94 (s, 9H). LCMS: RT=2.244 min, m/z 1002.3 [M+H]⁺.

### Example A-13: Synthesis of (2S,4R)-1-((S)-2-(tert-butyl)-17-(4-(((5S,8S)-4-hydroxy-3-mesityl-2-oxo-1-oxaspiro[4.5]dec-3-en-8-yl)oxy)piperidin-1-yl)-4-oxo-6,9,12,15-tetraoxa-3-azaheptadecanoyl)-4-hydroxy-N—((S)-1-(4-(4-methylthiazol-5-yl)phenyl)ethyl)pyrrolidine-2-carboxamide

### A. Step 1

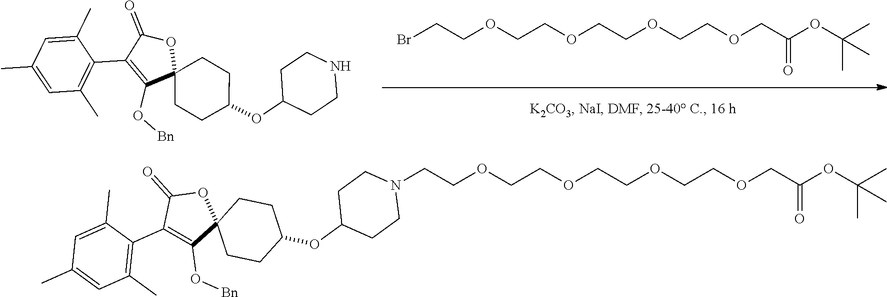

To a mixture of (5s,8s)-4-(benzyloxy)-3-mesityl-8-(piperidin-4-yloxy)-1-oxaspiro[4.5]dec-3-en-2-one (250 mg, 423.99 μmol, TFA salt; see Example 11, Step 5) and tert-butyl 2-[2-[2-[2-(2-bromoethoxy)ethoxy]ethoxy]ethoxy]acetate (157.41 mg, 423.99 μmol) in DMF (3 mL) were added K₂CO₃ (175.80 mg, 1.27 mmol) and NaI (63.55 mg, 423.99 μmol). The mixture was stirred at 25° C. for 12 hours and at 40° C. for 4 hours. The mixture was diluted with H₂O (20 mL) and extracted with EtOAc (20 mL×3). The combined organic layers were washed with brine (20 mL×3), dried over anhydrous Na₂SO₄, filtered and concentrated under reduced pressure to give a residue. The residue was purified by flash chromatography (silica gel, gradient elution from 0 to 3.5% MeOH:DCM) to give tert-butyl 14-(4-(((5s,8s)-4-(benzyloxy)-3-mesityl-2-oxo-1-oxaspiro[4.5]dec-3-en-8-yl)oxy)piperidin-1-yl)-3,6,9,12-tetraoxatetradecanoate (230 mg, 300.27 μmol, 70.82% yield) as a light-yellow oil. LCMS: RT=0.847 min, m/z 766.2 [M+H]⁺.

### B. Step 2

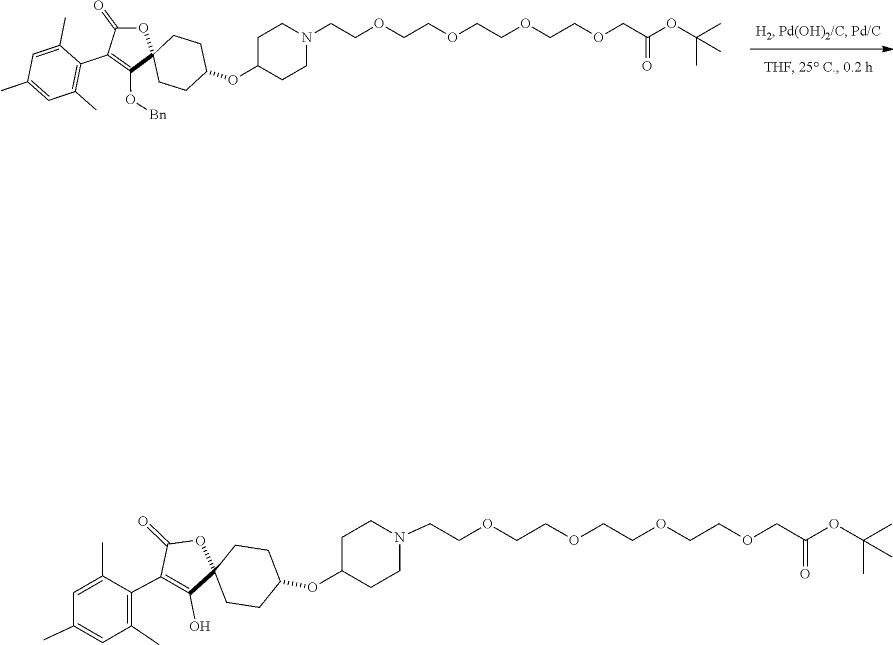

To a mixture of tert-butyl 14-(4-(((5s,8s)-4-(benzyloxy)-3-mesityl-2-oxo-1-oxaspiro[4.5]dec-3-en-8-yl)oxy)piperidin-1-yl)-3,6,9,12-tetraoxatetradecanoate (230 mg, 300.27 μmol) in THF (30 mL) were added 10% Pd/C (40 mg) and 20% Pd(OH)₂/C (40 mg) under N₂. The mixture was degassed, purged with H₂ (3×), and stirred at 25° C. for 0.2 hour under 15 psi H₂ (balloon). The mixture was filtered, and the filtrate concentrated to dryness at reduced pressure. The residue was purified by flash chromatography (silica gel, gradient elution from 0 to 5% MeOH:DCM) to afford tert-butyl 14-(4-(((5s,8s)-4-hydroxy-3-mesityl-2-oxo-1-oxaspiro[4.5]dec-3-en-8-yl)oxy)piperidin-1-yl)-3,6,9,12-tetraoxatetradecanoate (180 mg, 266.33 μmol, 88.70% yield) as a yellow oil. LCMS: RT=0.863 min, m/z 676.6 [M+H]⁺.

### C. Step 3

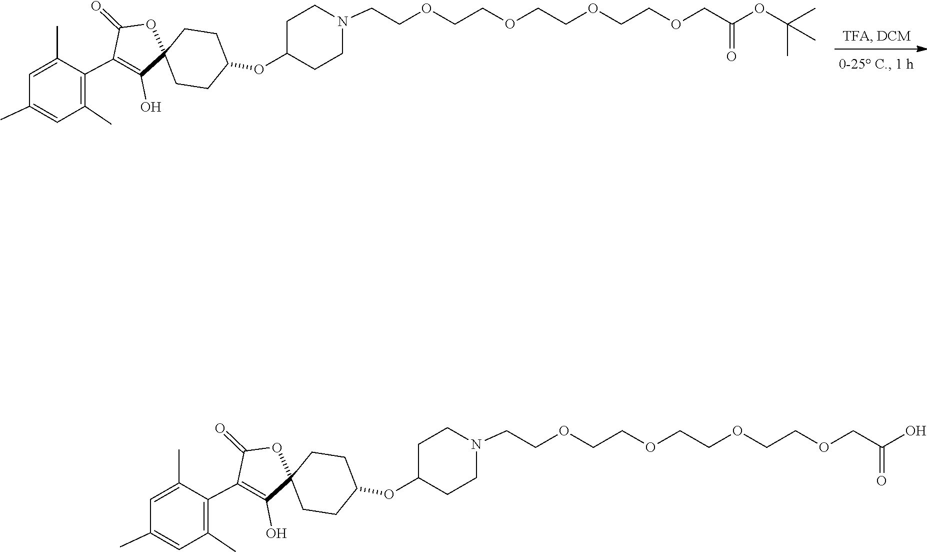

To a mixture of tert-butyl 14-(4-(((5s,8s)-4-hydroxy-3-mesityl-2-oxo-1-oxaspiro[4.5]dec-3-en-8-yl)oxy)piperidin-1-yl)-3,6,9,12-tetraoxatetradecanoate (180 mg, 266.33 μmol) in DCM (4 mL) was added TFA (3.08 g, 27.01 mmol, 2 mL) at 0° C. The mixture was stirred at 25° C. for 1 hour and then concentrated at reduced pressure to give 14-(4-(((5s,8s)-4-hydroxy-3-mesityl-2-oxo-1-oxaspiro[4.5]dec-3-en-8-yl)oxy)piperidin-1-yl)-3,6,9,12-tetraoxatetradecanoic acid (190 mg, crude, TFA salt) as a yellow oil, which was used in the next step without further purification. LCMS: RT=0.769 min, m/z 620.2 [M+H]⁺.

### D. Step 4

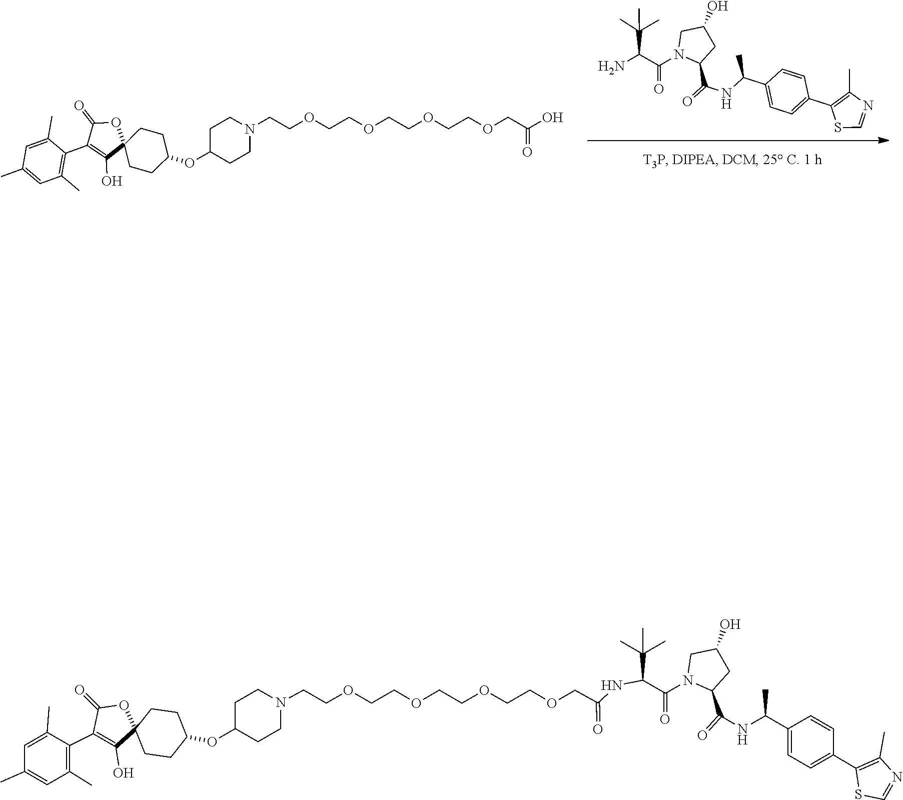

To a mixture of (2S,4R)-1-[(2S)-2-amino-3,3-dimethyl-butanoyl]-4-hydroxy-N-[(1 S)-1-[4-(4-methylthiazol-5-yl)phenyl]ethyl]pyrrolidine-2-carboxamide (133.74 mg, 278.02 μmol, HCl salt) and 14-(4-(((5s,8s)-4-hydroxy-3-mesityl-2-oxo-1-oxaspiro[4.5]dec-3-en-8-yl)oxy)piperidin-1-yl)-3,6,9,12-tetraoxatetradecanoic acid (170 mg, 231.68 μmol, TFA salt) in DCM (6 mL) were added 50% T₃P (221.15 mg, 347.52 μmol, 206.68 μL) and DIPEA (119.77 mg, 926.73 μmol, 161.42 μL). The mixture was stirred at 25° C. for 1 hour, diluted with H₂O (20 mL), and extracted with EtOAc (20 mL×3). The combined organic layers were dried over anhydrous Na₂SO₄, filtered, and concentrated at reduced pressure. The residue was purified by prep-HPLC (column: Phenomenex Luna C18, 150×25 mm×10 μm, mobile phase: [water (0.225% FA)-ACN], B %: 22-52, 10 min) to give (2S,4R)-1-((S)-2-(tert-butyl)-17-(4-(((5s,8s)-4-hydroxy-3-mesityl-2-oxo-1-oxaspiro[4.5]dec-3-en-8-yl)oxy)piperidin-1-yl)-4-oxo-6,9,12,15-tetraoxa-3-azaheptadecanoyl)-4-hydroxy-N—((S)-1-(4-(4-methylthiazol-5-yl)phenyl)ethyl)pyrrolidine-2-carboxamide (104.47 mg, 93.53 μmol, 40.37% yield, 97.8% purity) as a white solid. HNMR: DMSO-d₆, 400 MHz. δ 8.98 (s, 1H), 8.46 (d, J=8.0 Hz, 1H), 8.12 (s, 1H), 7.45-7.33 (m, 5H), 6.74 (s, 2H), 5.28-5.11 (m, 1H), 4.96-4.84 (m, 1H), 4.55 (d, J=9.6 Hz, 1H), 4.48-4.40 (m, 1H), 4.31-4.23 (m, 1H), 3.97 (s, 2H), 3.66-3.54 (m, 18H), 3.15-3.08 (m, 2H), 3.02-2.94 (m, 2H), 2.88-2.70 (m, 2H), 2.45 (s, 3H), 2.19 (s, 3H), 2.08-2.01 (m, 7H), 1.94-1.76 (m, 7H), 1.70-1.55 (m, 2H), 1.52-1.44 (m, 4H), 1.37 (d, J=7.2 Hz, 3H), 0.96-9.01 (m, 9H). LCMS: RT=0.648 min, m/z 369.9 [M+H]⁺.

### Example A-14: Synthesis of (2S,4R)-1-((S)-2-(tert-butyl)-17-(4-(((5S,8S)-4-hydroxy-3-mesityl-2-oxo-1-oxaspiro[4.5]dec-3-en-8-yl)oxy)piperidin-1-yl)-4-oxo-6,9,12,15-tetraoxa-3-azaheptadecanoyl)-4-hydroxy-N—((S)-1-(4-(4-methylthiazol-5-yl)phenyl)ethyl)pyrrolidine-2-carboxamide

### A. Step 1

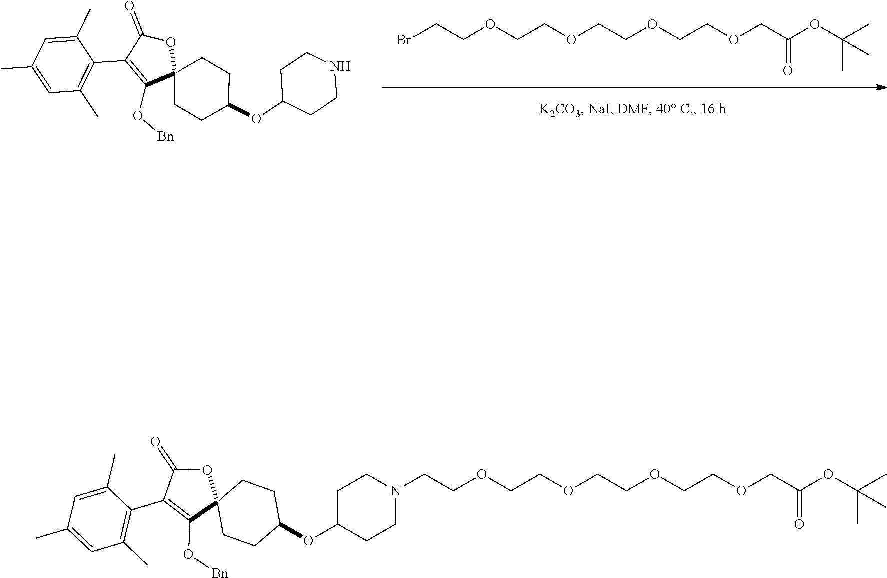

A mixture of (5r,8r)-4-(benzyloxy)-3-mesityl-8-(piperidin-4-yloxy)-1-oxaspiro[4.5]dec-3-en-2-one (250 mg, 423.99 μmol, TFA salt; prepared from (5r,8r)-4-(benzyloxy)-8-hydroxy-3-mesityl-1-oxaspiro[4.5]dec-3-en-2-one using the general methods described in Example 11), tert-butyl 2-[2-[2-[2-(2-bromoethoxy)ethoxy]ethoxy]ethoxy]acetate (236.12 mg, 635.98 μmol), NaI (63.55 mg, 423.99 μmol) and K₂CO₃ (351.59 mg, 2.54 mmol) in DMF (5 mL). The mixture was stirred at 40° C. for 16 hours under N₂, quenched by addition of water (20 mL), and extracted with DCM (20 mL×3). The combined organic layers were dried over anhydrous Na₂SO₄, filtered, and concentrated to dryness at reduced pressure. The residue was purified by column chromatography (silica gel, gradient elution from 1 to 10% MeOH in DCM) to give tert-butyl 14-(4-(((5r,8r)-4-(benzyloxy)-3-mesityl-2-oxo-1-oxaspiro[4.5]dec-3-en-8-yl)oxy)piperidin-1-yl)-3,6,9,12-tetraoxatetradecanoate (435 mg, crude) as a yellow oil. HNMR: CDCl₃, 400 MHz. δ 8.02 (s, 2H), 7.72-7.63 (m, 1H), 7.51-7.43 (m, 1H), 7.28-7.25 (m, 1H), 6.98-6.96 (m, 1H), 6.88 (s, 1H), 5.31 (s, 2H), 4.81 (s, 1H), 4.02 (s, 1H), 3.71-3.66 (m, 8H), 3.47 (s, 2H), 2.96 (s, 9H), 2.89 (s, 9H), 2.17 (s, 6H), 2.06 (s, 4H), 1.94-1.86 (m, 4H), 1.48 (s, 6H), 1.25-1.23 (m, 4H). LCMS: RT=0.876 min, m/z 766.3 [M+H]⁺.

### B. Step 2

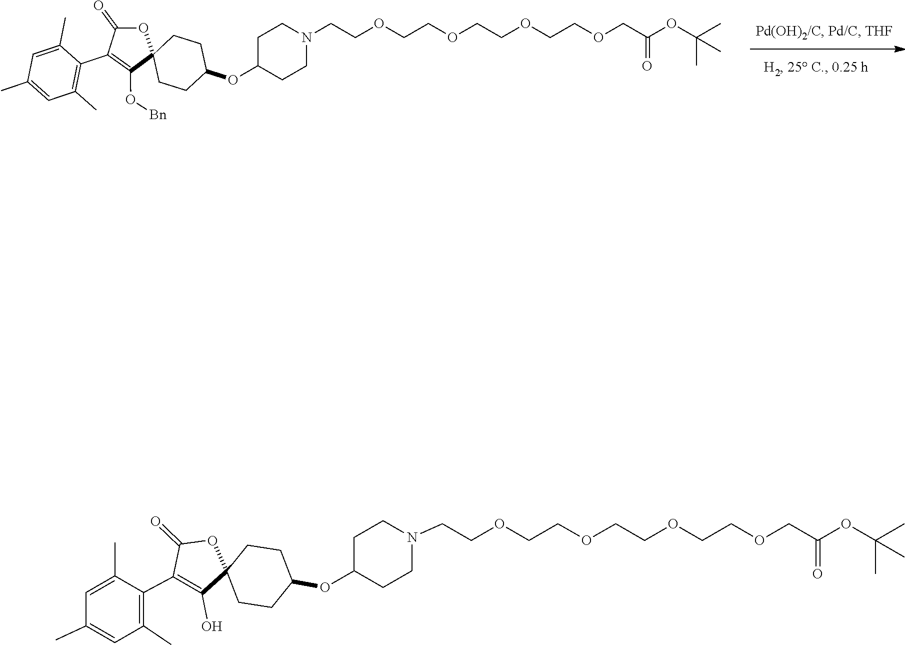

To a solution of tert-butyl 14-(4-(((5r,8r)-4-(benzyloxy)-3-mesityl-2-oxo-1-oxaspiro[4.5]dec-3-en-8-yl)oxy)piperidin-1-yl)-3,6,9,12-tetraoxatetradecanoate (415 mg, 541.80 μmol) in THE (10 mL) was added 10% Pd/C (50 mg) and 20% Pd(OH)₂/C (50 mg) under N₂. The mixture was degassed, purged with H₂ (3×), and stirred at 25° C. for 0.25 hour under 15 psi H₂ (balloon). The reaction mixture was filtered and the filtrate concentrated at reduced pressure to give tert-butyl 14-(4-(((5r,8r)-4-hydroxy-3-mesityl-2-oxo-1-oxaspiro[4.5]dec-3-en-8-yl)oxy)piperidin-1-yl)-3,6,9,12-tetraoxatetradecanoate (294 mg, crude) as a yellow oil, which was used in the next step without further purification.

### C. Step 3

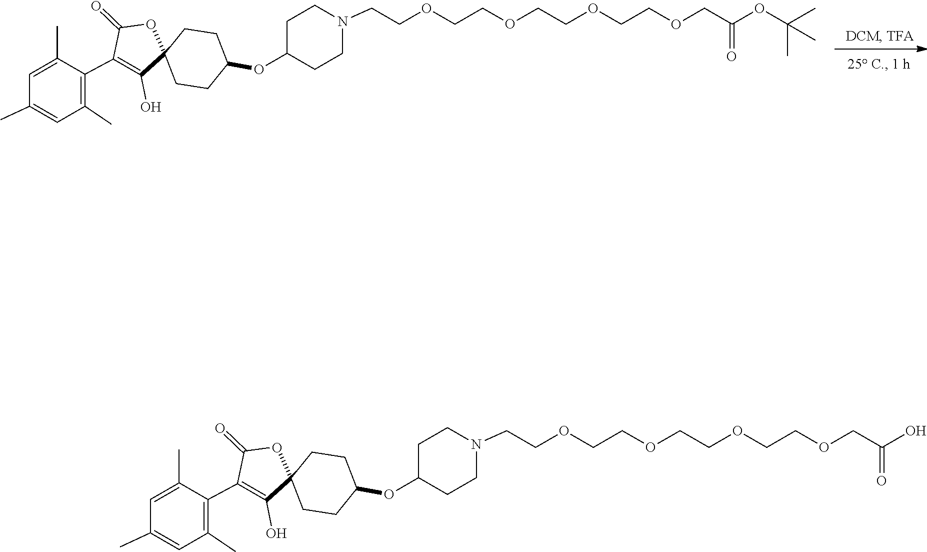

A mixture of tert-butyl 14-(4-(((5r,8r)-4-hydroxy-3-mesityl-2-oxo-1-oxaspiro[4.5]dec-3-en-8-yl)oxy)-piperidin-1-yl)-3,6,9,12-tetraoxatetradecanoate (274 mg, 405.42 μmol) in DCM (3 mL) and TFA (3 mL) was stirred at 25° C. for 1 hour under N₂. The reaction mixture was concentrated under reduced pressure to give 14-(4-(((5r,8r)-4-hydroxy-3-mesityl-2-oxo-1-oxaspiro[4.5]dec-3-en-8-yl)oxy)piperidin-1-yl)-3,6,9,12-tetraoxatetradecanoic acid (477 mg, crude, TFA salt) as a yellow oil, which was used in the next step without further purification.

### D. Step 4

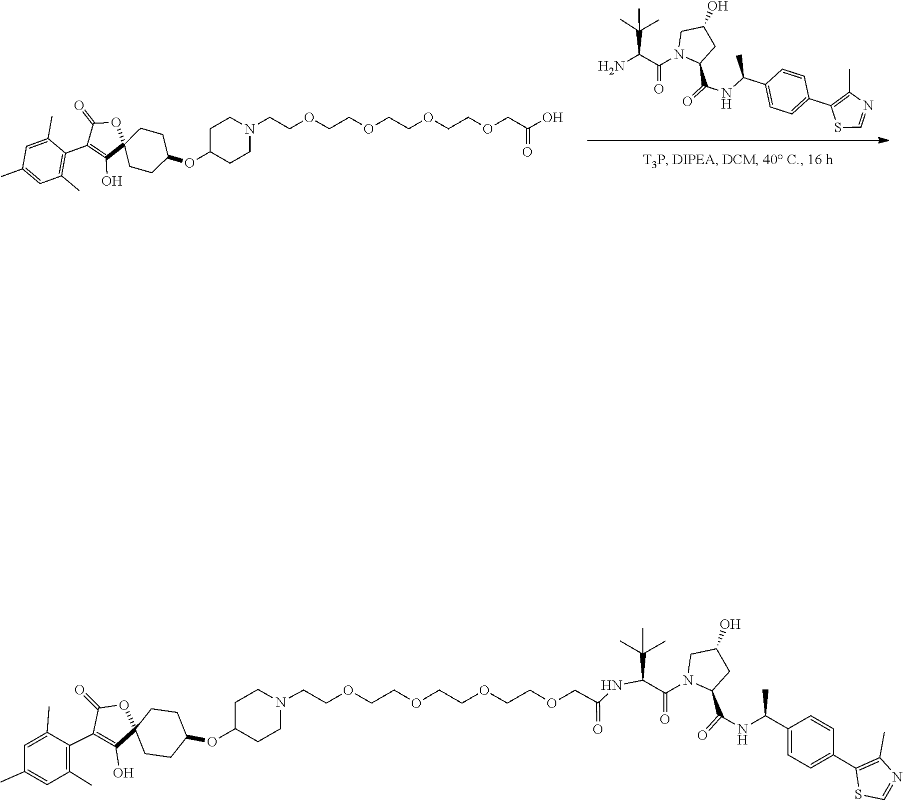

A mixture of 14-(4-(((5r,8r)-4-hydroxy-3-mesityl-2-oxo-1-oxaspiro[4.5]dec-3-en-8-yl)oxy)piperidin-1-yl)-3,6,9,12-tetraoxatetradecanoic acid (477 mg, 650.07 μmol, TFA salt), (2S,4R)-1-[(2S)-2-amino-3,3-dimethyl-butanoyl]-4-hydroxy-N-[(1 S)-1-[4-(4-methylthiazol-5-yl)phenyl]ethyl]pyrrolidine-2-carboxamide (406.53 mg, 845.09 μmol, HCl salt), 50% T₃P (517.10 mg, 1.63 mmol, 483.27 μL) and DIPEA (840.17 mg, 6.50 mmol, 1.13 mL) in THF (10 mL) was stirred at 40° C. for 16 hours under N₂. The reaction mixture was diluted with water (100 mL) and extracted with DCM (20 mL×3). The combined organic phases were dried over anhydrous Na₂SO₄ and concentrated to dryness at reduced pressure. The residue was purified by prep-HPLC (column: Phenomenex Gemini-NX C18, 75×30 mm×3 m, mobile phase: [water (0.225% FA)-ACN], B %: 22-52, 7 min) to afford (2S,4R)-1-((S)-2-(tert-butyl)-17-(4-(((5r,8r)-4-hydroxy-3-mesityl-2-oxo-1-oxaspiro[4.5]dec-3-en-8-yl)oxy)piperidin-1-yl)-4-oxo-6,9,12,15-tetraoxa-3-azaheptadecanoyl)-4-hydroxy-N—((S)-1-(4-(4-methylthiazol-5-yl)phenyl)ethyl)pyrrolidine-2-carboxamide (90.4 mg, 82.94 μmol, 12.76% yield, 96% purity) as a white solid. HNMR DMSO-d₆, 400 MHz. δ 8.98 (s, 1H), 8.45-8.43 (m, 1H), 8.13 (s, 1H), 7.45-7.35 (m, 5H), 6.75 (s, 2H), 5.34-5.06 (m, 1H), 4.89 (t, J=6.8 Hz, 1H), 4.54 (d, J=9.6 Hz, 1H), 4.44 (t, J=8.0 Hz, 1H), 4.26 (s, 1H), 3.97 (s, 2H), 3.73 (s, 1H), 3.63-3.54 (m, 17H), 3.10-3.03 (m, 2H), 2.92-2.77 (m, 4H), 2.45 (s, 3H), 2.19 (s, 3H), 2.07 (s, 10H), 1.92-1.86 (m, 2H), 1.79-1.64 (m, 6H), 1.37 (d, J=7.2 Hz, 3H), 1.27 (d, J=12.0 Hz, 2H), 0.94 (s, 9H). LCMS: RT=2.624 min, m/z 1046.6 [M+H]⁺.

### Example A-15: Synthesis of (2S,4R)-1-((S)-2-(tert-butyl)-20-(4-(((5S,8S)-4-hydroxy-3-mesityl-2-oxo-1-oxaspiro[4.5]dec-3-en-8-yl)oxy)piperidin-1-yl)-4-oxo-6,9,12,15,18-pentaoxa-3-azaicosanoyl)-4-hydroxy-N—((S)-1-(4-(4-methylthiazol-5-yl)phenyl)ethyl)pyrrolidine-2-carboxamide

### A. Step 1

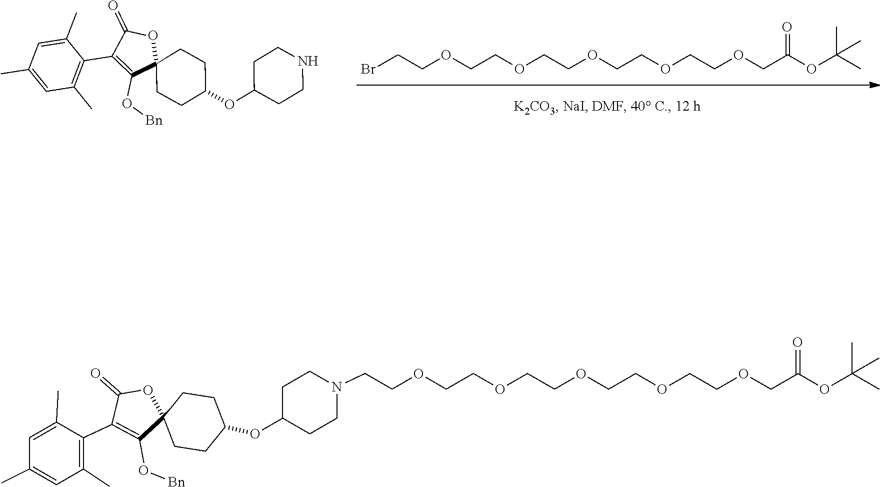 [SMILES: Cc1cc(C)c(C2=C(OCc3ccccc3)[C@]3(CC[C@H](OC4CCNCC4)CC3)OC2=O)c(C)c1 ; CC(C)(C)OC(=O)COCCOCCOCCOCCOCCBr ; Cc1cc(C)c(C2=C(OCc3ccccc3)[C@]3(CC[C@H](OC4CCN(CCOCCOCCOCCOCCOCC(=O)OC(C)(C)C)CC4)CC3)OC2=O)c(C)c1]

To a mixture of (5s,8s)-4-(benzyloxy)-3-mesityl-8-(piperidin-4-yloxy)-1-oxaspiro[4.5]dec-3-en-2-one (220 mg, 373.11 μmol, TFA salt; see Example 11, Step 5) in DMF (5 mL) were added tert-butyl 2-[2-[2-[2-[2-(2-bromoethoxy)ethoxy]ethoxy]ethoxy]ethoxy]acetate (201.45 mg, 485.04 μmol), K₂CO₃ (154.70 mg, 1.12 mmol) and NaI (55.93 mg, 373.11 μmol). The mixture was stirred at 40° C. for 12 hours, diluted with EtOAc (10 mL) and water (20 mL) and the layers separated. The aqueous phase was extracted with EtOAc (10 mL×3). The combined extracts were washed with brine (20 mL), dried over Na₂SO₄, filtered, and concentrated under vacuum to give a residue. The residue was purified by flash chromatography (silica gel, gradient elution from 0 to 10% MeOH:DCM) to give tert-butyl 17-(4-(((5s,8s)-4-(benzyloxy)-3-mesityl-2-oxo-1-oxaspiro[4.5]dec-3-en-8-yl)oxy)piperidin-1-yl)-3,6,9,12,15-pentaoxaheptadecanoate (300 mg, 370.36 μmol, 99.26% yield) as a colorless oil. LCMS: RT=0.754 min, m/z 810.9 [M+H]⁺.

### B. Step 2

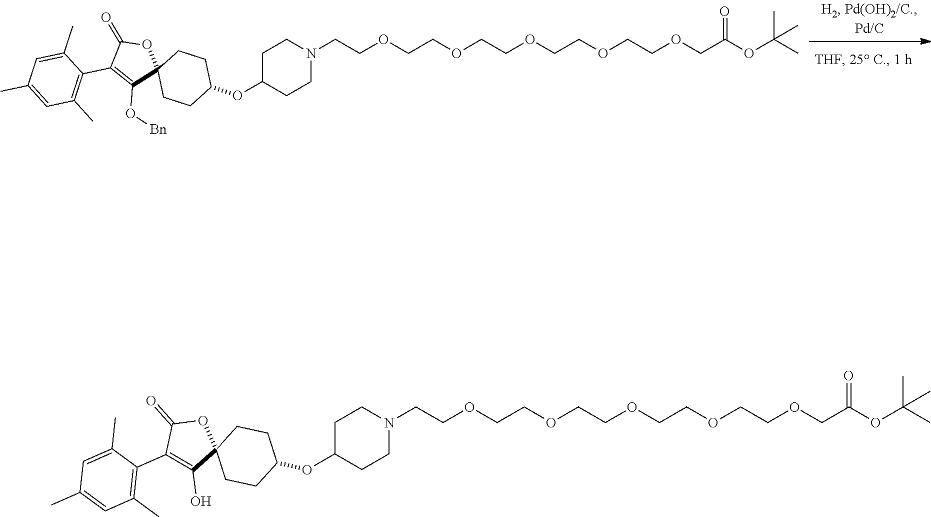

To a mixture of tert-butyl 17-(4-(((5s,8s)-4-(benzyloxy)-3-mesityl-2-oxo-1-oxaspiro[4.5]dec-3-en-8-yl)oxy)piperidin-1-yl)-3,6,9,12,15-pentaoxaheptadecanoate (300 mg, 370.36 μmol) in THE (10 mL) were added 10% Pd/C (50 mg) and 10% Pd(OH)₂ (50 mg) under N₂. The mixture was degassed, purged with H₂ (3×), and stirred at 25° C. for 1 hour under 15 psi H₂ (balloon). The mixture was filtered and the filtrate concentrated in vacuo to give tert-butyl 17-(4-(((5s,8s)-4-hydroxy-3-mesityl-2-oxo-1-oxaspiro[4.5]dec-3-en-8-yl)oxy)piperidin-1-yl)-3,6,9,12,15-pentaoxaheptadecanoate (250 mg, crude) as a yellow liquid, which was used in the next step without further purification. LCMS: RT=0.878 min, m/z 720.7 [M+H]⁺.

### C. Step 3

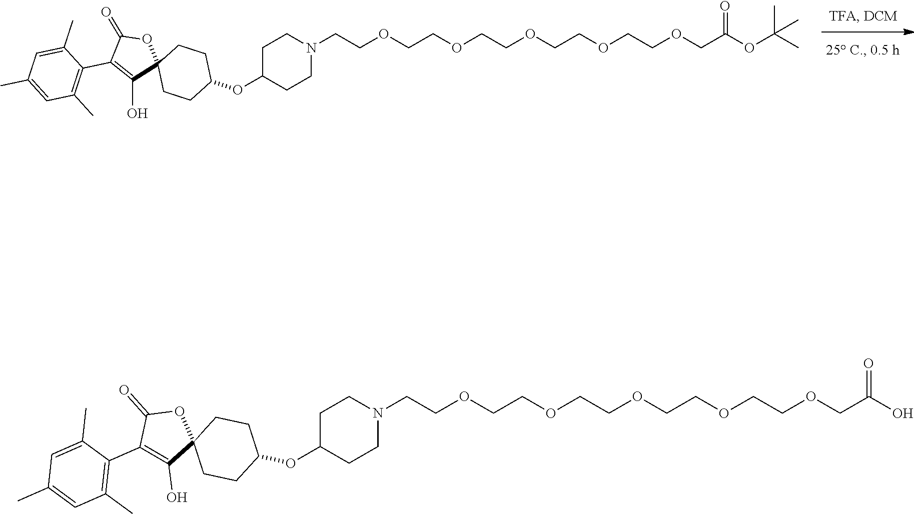

To a mixture of tert-butyl 17-(4-(((5s,8s)-4-hydroxy-3-mesityl-2-oxo-1-oxaspiro[4.5]dec-3-en-8-yl)oxy)piperidin-1-yl)-3,6,9,12,15-pentaoxaheptadecanoate (250 mg, 347.27 μmol, crude) in DCM (3 mL) was added TFA (4.62 g, 40.52 mmol, 3 mL). The mixture was stirred at 25° C. for 0.5 hour and then evaporated at reduced pressure give 17-(4-(((5s,8s)-4-hydroxy-3-mesityl-2-oxo-1-oxaspiro[4.5]dec-3-en-8-yl)oxy)piperidin-1-yl)-3,6,9,12,15-pentaoxaheptadecanoic acid (270 mg, crude, TFA salt) as a brown oil, which was used in the next step without further purification. LCMS: RT=0.826 min, m/z 664.3 [M+H]⁺.

### D. Step 4

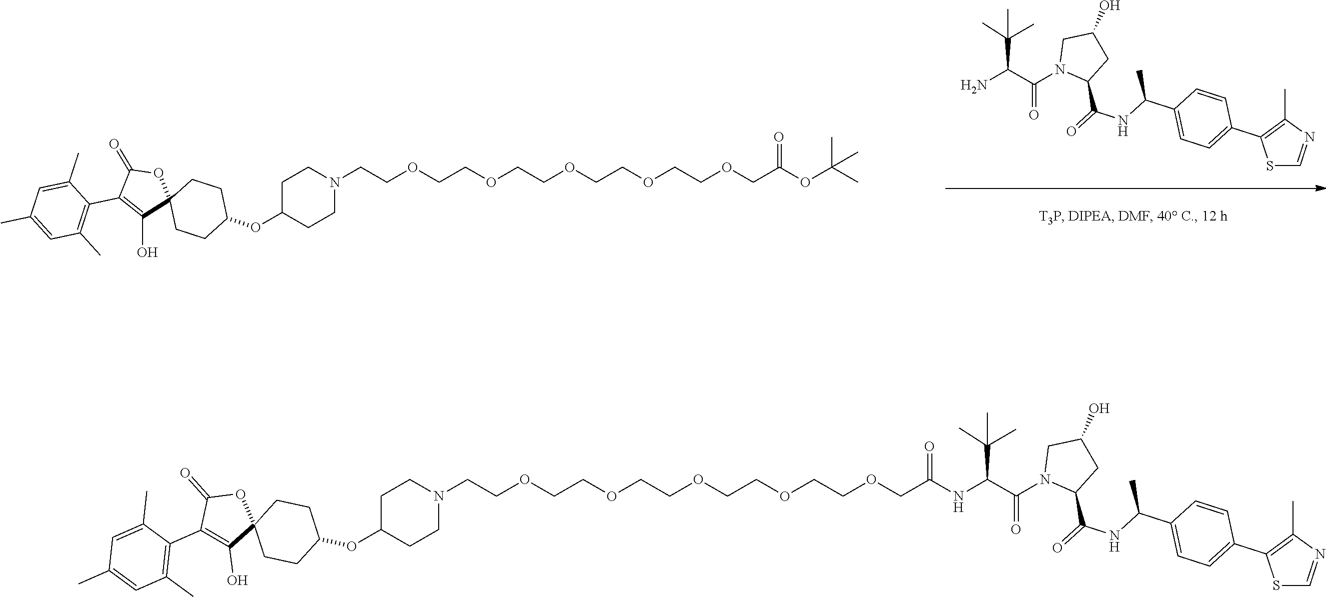

To a mixture of 17-(4-(((5s,8s)-4-hydroxy-3-mesityl-2-oxo-1-oxaspiro[4.5]dec-3-en-8-yl)oxy)piperidin-1-yl)-3,6,9,12,15-pentaoxaheptadecanoic acid (220 mg, 282.84 μmol, crude, TFA salt) in THF (5 mL) were added (2S,4R)-1-[(2S)-2-amino-3,3-dimethyl-butanoyl]-4-hydroxy-N-[(1S)-1-[4-(4-methylthiazol-5-yl)phenyl]ethyl]pyrrolidine-2-carboxamide (204.09 mg, 424.26 μmol, HCl salt), 50% T₃P (539.97 mg, 848.53 μmol, 504.65 μL) and DIPEA (292.44 mg, 2.26 mmol, 394.13 μL). The mixture was stirred at 40° C. for 12 hours and concentrated to dryness at reduced pressure. The residue was purified by prep-HPLC (column: Phenomenex Luna C18, 150×25 mm×10 μm, mobile phase: [water (0.225% FA)-ACN], B %: 22-52, 10 min) to give (2S,4R)-1-((S)-2-(tert-butyl)-20-(4-(((5s,8s)-4-hydroxy-3-mesityl-2-oxo-1-oxaspiro[4.5]dec-3-en-8-yl)oxy)piperidin-1-yl)-4-oxo-6,9,12,15,18-pentaoxa-3-azaicosanoyl)-4-hydroxy-N—((S)-1-(4-(4-methylthiazol-5-yl)phenyl)ethyl)pyrrolidine-2-carboxamide (102.26 mg, 93.19 μmol, 32.95% yield, 99.4% purity) as a white solid. HNMR: DMSO-d₆, 400 MHz. δ 8.98 (s, 1H), 8.45 (d, J=7.6 Hz, 1H), 7.45-7.33 (m, 6H), 6.74 (s, 2H), 4.90 (t, J=7.2 Hz, 1H), 4.54 (d, J=9.6 Hz, 1H), 4.44 (t, J=8.0 Hz, 1H), 4.27 (s, 1H), 3.97 (s, 2H), 3.61-3.52 (m, 22H), 3.10-2.93 (m, 5H), 2.45 (s, 3H), 2.19 (s, 3H), 2.04 (s, 6H), 1.90-1.73 (m, 8H), 1.64-1.59 (m, 1H), 1.52-1.42 (m, 6H), 1.37 (d, J=7.2 Hz, 3H), 0.94 (s, 9H). LCMS: RT=2.208 min, m/z 1090.6 [M+H]⁺.

### Example A-16: Synthesis of (2S,4R)-1-((S)-2-(tert-butyl)-20-(4-(((5R,8R)-4-hydroxy-3-mesityl-2-oxo-1-oxaspiro[4.5]dec-3-en-8-yl)oxy)piperidin-1-yl)-4-oxo-6,9,12,15,18-pentaoxa-3-azaicosanoyl)-4-hydroxy-N—((S)-1-(4-(4-methylthiazol-5-yl)phenyl)ethyl)pyrrolidine-2-carboxamide

### A. Step 1

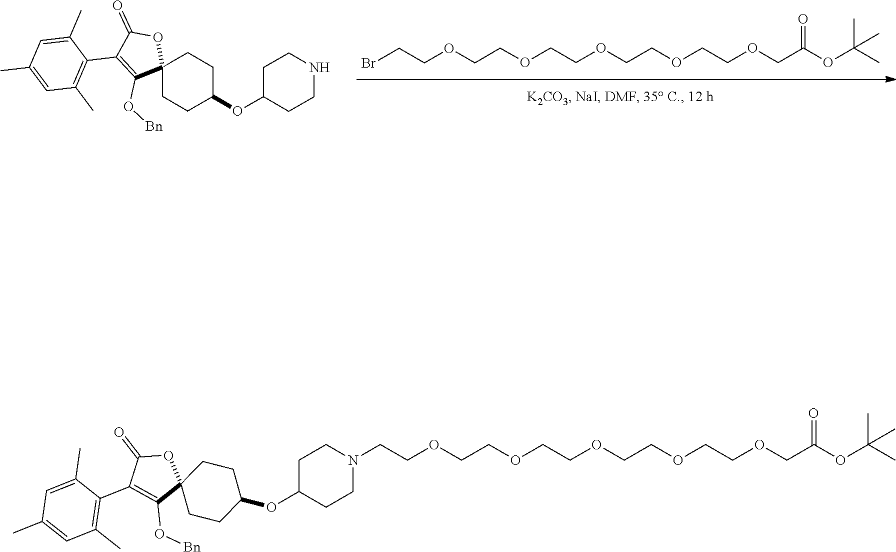 [SMILES: Cc1cc(C)c(C2=C(OCc3ccccc3)[C@]3(CC[C@@H](OC4CCNCC4)CC3)OC2=O)c(C)c1 ; CC(C)(C)OC(=O)COCCOCCOCCOCCOCCBr ; Cc1cc(C)c(C2=C(OCc3ccccc3)[C@]3(CC[C@@H](OC4CCN(CCOCCOCCOCCOCCOCC(=O)OC(C)(C)C)CC4)CC3)OC2=O)c(C)c1]

To a mixture of (5r,8r)-4-(benzyloxy)-3-mesityl-8-(piperidin-4-yloxy)-1-oxaspiro[4.5]dec-3-en-2-one (238 mg, 403.64 μmol, TFA salt; prepared from (5r,8r)-4-(benzyloxy)-8-hydroxy-3-mesityl-1-oxaspiro[4.5]dec-3-en-2-one using the general methods described in Example 11) and tert-butyl 17-bromo-3,6,9,12,15-pentaoxaheptadecanoate (201.16 mg, 484.36 μmol) in DMF (5 mL) were added K₂CO₃ (167.35 mg, 1.21 mmol) and NaI (6.05 mg, 40.36 μmol). The mixture was stirred at 35° C. for 12 hours. The reaction mixture was diluted with water (20 mL) and EtOAc (30 mL) and the phases separated. The aqueous phase was extracted with EtOAc (30 mL×3). The combined organic phases were washed with brine (20 mL×3), dried over Na₂SO₄, filtered, and concentrated in vacuo. The residue was purified by prep-TLC (silica gel, 10:1 DCM:MeOH) to give tert-butyl 17-(4-(((5r,8r)-4-(benzyloxy)-3-mesityl-2-oxo-1-oxaspiro[4.5]dec-3-en-8-yl)oxy)piperidin-1-yl)-3,6,9,12,15-pentaoxaheptadecanoate (220 mg, 271.60 μmol, 67.29% yield) as a colorless oil. LCMS: RT=0.960 min, m/z=810.5 [M+H]⁺.

### B. Step 2

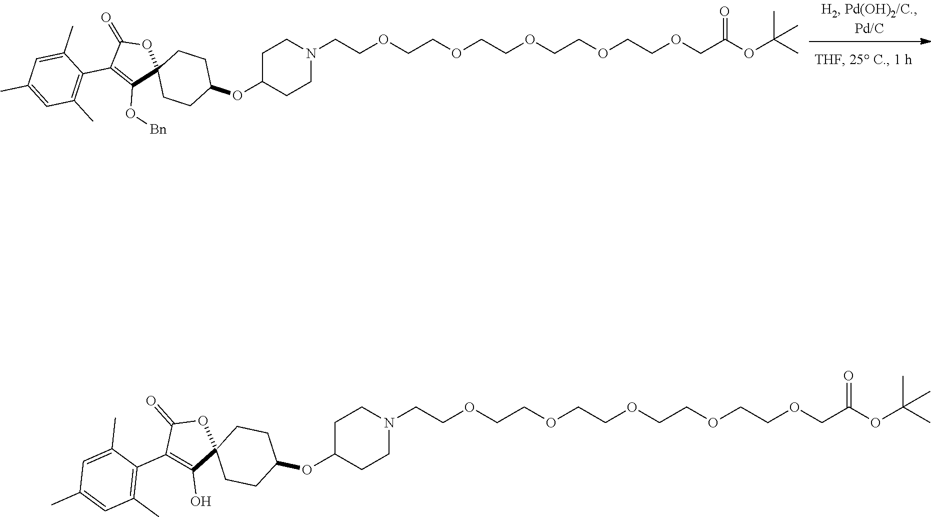

To a mixture of tert-butyl 17-(4-(((5r,8r)-4-(benzyloxy)-3-mesityl-2-oxo-1-oxaspiro[4.5]dec-3-en-8-yl)oxy)piperidin-1-yl)-3,6,9,12,15-pentaoxaheptadecanoate (220 mg, 271.60 μmol) in THF (6 mL) were added 10% Pd(OH)₂/C (50 mg) and 10% Pd/C (100 mg) under N₂. The mixture was degassed, purged with H₂ (3×), and stirred at 25° C. for 1 hour under 15 psi H₂ (balloon). The mixture was filtered and the filtrate concentrated at reduced pressure to give tert-butyl 17-(4-(((5r,8r)-4-hydroxy-3-mesityl-2-oxo-1-oxaspiro[4.5]dec-3-en-8-yl)oxy)piperidin-1-yl)-3,6,9,12,15-pentaoxaheptadecanoate (180 mg, crude) as colorless oil, which was used in the next step without further purification. LCMS: RT=0.887 min, m/z=720.6 [M+H]⁺.

### C. Step 3

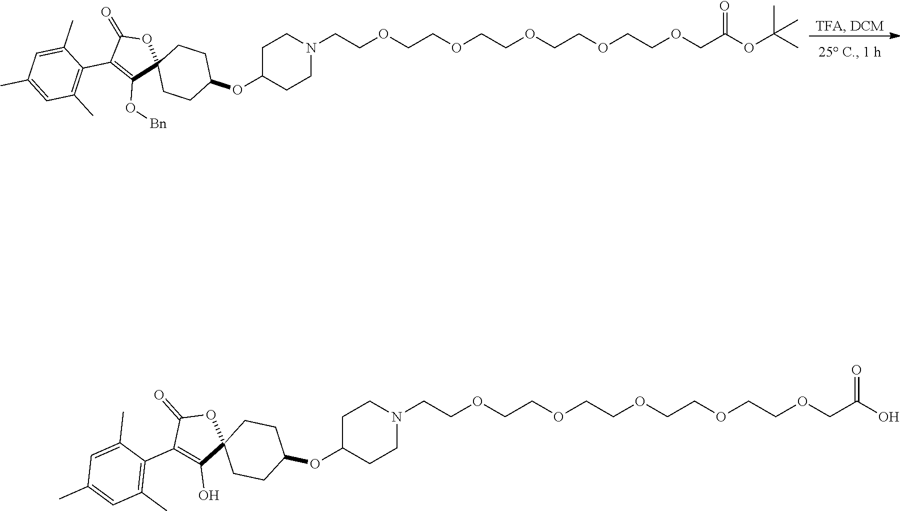

A mixture of tert-butyl 17-(4-(((5r,8r)-4-hydroxy-3-mesityl-2-oxo-1-oxaspiro[4.5]dec-3-en-8-yl)oxy)-piperidin-1-yl)-3,6,9,12,15-pentaoxaheptadecanoate (174 mg, 241.70 μmol) in TFA (4.62 g, 40.52 mmol, 3 mL) and DCM (6 mL) was stirred at 25° C. for 1 hour and then concentrated to dryness at reduced pressure to afford 17-(4-(((5r,8R)-4-hydroxy-3-mesityl-2-oxo-1-oxaspiro[4.5]dec-3-en-8-yl)oxy)piperidin-1-yl)-3,6,9,12,15-pentaoxaheptadecanoic acid (188 mg, crude, TFA) as a brown oil, which was used in the next step without further purification. LCMS: RT=0.629 min, m/z=664.3 [M+H]⁺.

### D. Step 4

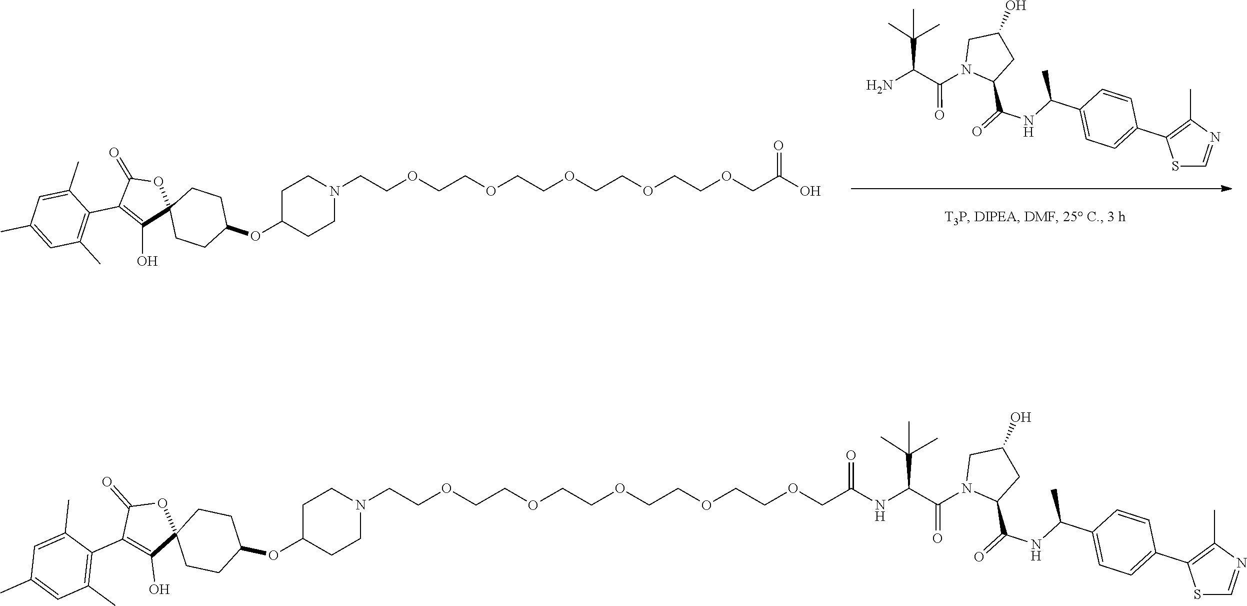

To a mixture of 17-(4-(((5r,8r)-4-hydroxy-3-mesityl-2-oxo-1-oxaspiro[4.5]dec-3-en-8-yl)oxy)piperidin-1-yl)-3,6,9,12,15-pentaoxaheptadecanoic acid (188 mg, 241.70 μmol, TFA salt) and (2S,4R)-1-((S)-2-amino-3,3-dimethylbutanoyl)-4-hydroxy-N—((S)-1-(4-(4-methylthiazol-5-yl)phenyl)ethyl)pyrrolidine-2-carboxamide (174.41 mg, 362.55 μmol, HCl salt) in DCM (6 mL) were added DIPEA (156.19 mg, 1.21 mmol, 210.50 μL) and 50% T₃P (199.95 mg, 314.21 μmol, 186.87 μL). The mixture was stirred at 25° C. for 3 hours and concentrated to dryness at reduced pressure. The residue was purified by prep-HPLC (column: Waters Xbridge, 150×25 mm×5 μm, mobile phase: [water (10 mM NH₄HCO₃)-ACN], B %: 22-52, 10 min) to afford (2S,4R)-1-((S)-2-(tert-butyl)-20-(4-(((5r,8r)-4-hydroxy-3-mesityl-2-oxo-1-oxaspiro[4.5]dec-3-en-8-yl)oxy)piperidin-1-yl)-4-oxo-6,9,12,15,18-pentaoxa-3-azaicosanoyl)-4-hydroxy-N—((S)-1-(4-(4-methylthiazol-5-yl)phenyl)ethyl)pyrrolidine-2-carboxamide (102.26 mg, 93.38 μmol, 38.63% yield, 99.57% purity) as a white solid. HNMR: DMSO-d₆, 400 MHz. δ 9.08-8.90 (m, 1H), 8.50-8.37 (m, 1H), 7.46-7.31 (m, 5H), 6.82-6.66 (m, 2H), 5.26-5.09 (m, 1H), 4.97-4.82 (m, 1H), 4.59-4.51 (m, 1H), 4.47-4.39 (m, 1H), 4.29-4.19 (m, 1H), 3.99-3.91 (m, 2H), 3.72-3.51 (m, 22H), 3.09-2.98 (m, 2H), 2.90-2.56 (m, 4H), 2.47-2.44 (m, 3H), 2.19 (s, 3H), 2.11-2.02 (m, 9H), 1.92-1.84 (m, 2H), 1.81-1.57 (m, 7H), 1.47-1.33 (m, 3H), 1.30-1.21 (m, 2H), 0.97-0.91 (m, 9H). LCMS: RT=2.255 min, m/z=1090.5 [M+H]⁺.

### Example A-17: Synthesis of (2S,4R)-4-hydroxy-1-((S)-2-(2-(2-(4-(2-(((5S,8S)-4-hydroxy-3-mesityl-2-oxo-1-oxaspiro[4.5]dec-3-en-8-yl)oxy)ethyl)piperazin-1-yl)ethoxy)acetamido)-3,3-dimethylbutanoyl)-N—((S)-1-(4-(4-methylthiazol-5-yl)phenyl)ethyl)pyrrolidine-2-carboxamide

### A. Step 1

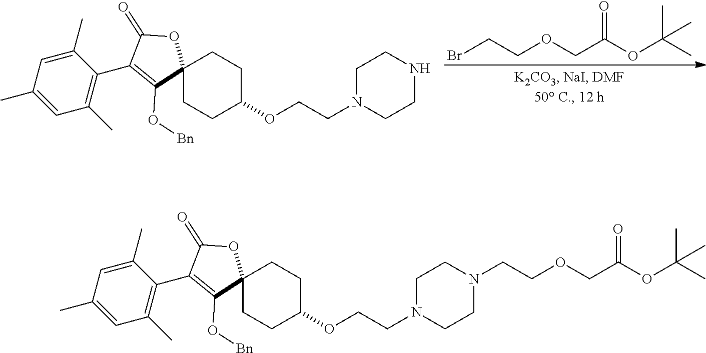

To a solution of (5s,8s)-4-(benzyloxy)-3-mesityl-8-(2-(piperazin-1-yl)ethoxy)-1-oxaspiro[4.5]dec-3-en-2-one (465.75 mg, 752.80 μmol, TFA salt; see Example 19, Step 3) and tert-butyl 2-(2-bromoethoxy)acetate (150 mg, 627.34 μmol) in DMF (2 mL) were added NaI (9.40 mg, 62.73 μmol) and K₂CO₃ (260.11 mg, 1.88 mmol). The mixture was stirred at 50° C. for 12 hours. The reaction mixture was diluted with H₂O (20 mL) and extracted with EtOAc (40 mL×3). The combined organic layers were washed with brine (60 mL×3), dried over anhydrous Na₂SO₄, filtered, and concentrated at reduced pressure to give a residue. The residue was purified by column chromatography (silica gel, gradient elution from 20:1 to 15:1 DCM:MeOH) to afford tert-butyl 2-(2-(4-(2-(((5s,8s)-4-(benzyloxy)-3-mesityl-2-oxo-1-oxaspiro[4.5]dec-3-en-8-yl)oxy)ethyl)piperazin-1-yl)ethoxy)acetate (200 mg, 301.73 μmol, 48.10% yield) as a yellow oil. LCMS: RT=0.794 min, m/z 663.5 [M+H]⁺.

### B. Step 2

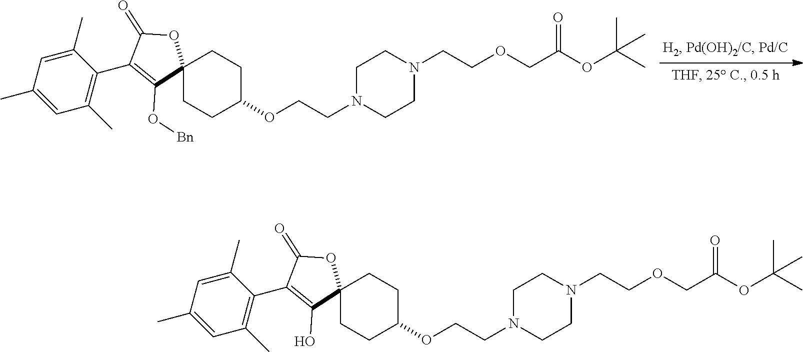

To a mixture of tert-butyl 2-(2-(4-(2-(((5s,8s)-4-(benzyloxy)-3-mesityl-2-oxo-1-oxaspiro[4.5]dec-3-en-8-yl)oxy)ethyl)piperazin-1-yl)ethoxy)acetate (170 mg, 256.47 μmol) in THF (20 mL) were added 10% Pd/C (20 mg) and 20% Pd(OH)₂/C (20 mg) under N₂. The mixture was degassed, purged with H₂ (3×), and stirred at 25° C. for 0.5 hour under 15 psi H₂ (balloon). The mixture was filtered and the filtrate concentrated under reduced pressure to give tert-butyl 2-(2-(4-(2-(((5s,8s)-4-hydroxy-3-mesityl-2-oxo-1-oxaspiro[4.5]dec-3-en-8-yl)oxy)ethyl)piperazin-1-yl)ethoxy)acetate (130 mg, 226.98 μmol, 88.50% yield) as a colorless oil, which was used in the next step without further purification. LCMS: RT=0.809 min, m % z 573.5 [M+H]⁺.

### C. Step 3

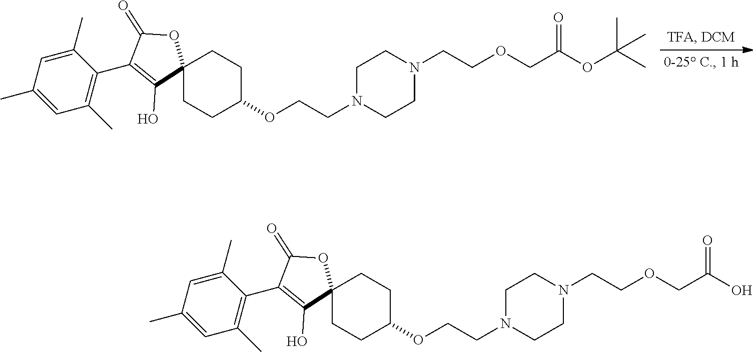

To a mixture of tert-butyl 2-(2-(4-(2-(((5s,8s)-4-hydroxy-3-mesityl-2-oxo-1-oxaspiro[4.5]dec-3-en-8-yl)oxy)ethyl)piperazin-1-yl)ethoxy)acetate (130 mg, 226.98 μmol) in DCM (6 mL) was added TFA (4.62 g, 40.52 mmol, 3 mL) at 0° C. The mixture was stirred at 25° C. for 1 hour and concentrated to dryness under reduced pressure to give 2-(2-(4-(2-(((5s,8s)-4-hydroxy-3-mesityl-2-oxo-1-oxaspiro[4.5]dec-3-en-8-yl)oxy)ethyl)piperazin-1-yl)ethoxy)acetic acid (110 mg, 212.92 μmol, 93.80% yield) as a yellow oil, which was used in the next step without further purification. LCMS: RT=0.567 min, m/z 517.2 [M+H]⁺.

### D. Step 4

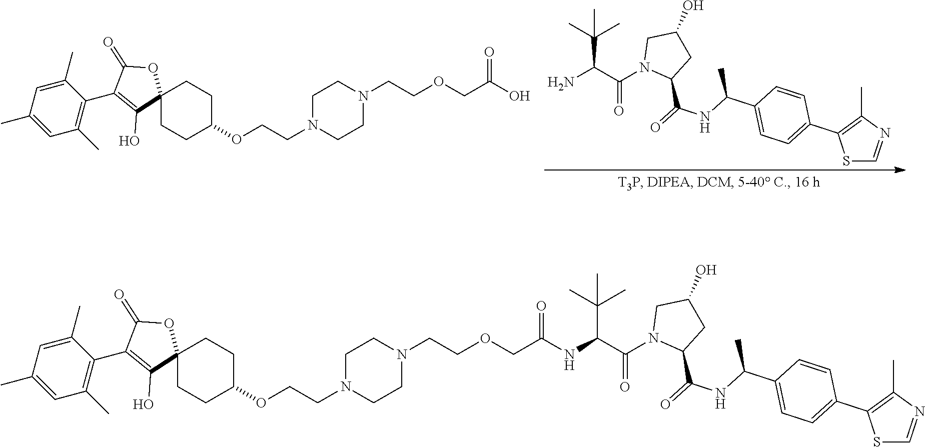

To a mixture of (2S,4R)-1-[(2S)-2-amino-3,3-dimethyl-butanoyl]-4-hydroxy-N-[(1S)-1-[4-(4-methylthiazol-5-yl)phenyl]ethyl]pyrrolidine-2-carboxamide (111.74 mg, 232.28 μmol, HCl salt) and 2-(2-(4-(2-(((5s,8s)-4-hydroxy-3-mesityl-2-oxo-1-oxaspiro[4.5]dec-3-en-8-yl)oxy)ethyl)piperazin-1-yl)ethoxy)acetic acid (100 mg, 193.56 μmol) in DCM (1 mL) were added 50% T₃P (184.76 mg, 290.35 μmol, 172.68 μL) and DIPEA (100.06 mg, 774.26 μmol, 134.86 μL). The mixture was stirred at 25° C. for 12 hours and 40° C. for 4 hours. The reaction mixture was diluted with H₂O (20 mL) and extracted with EtOAc (20 mL×3). The combined organic layers were washed with brine (20 mL), dried over anhydrous Na₂SO₄, filtered, and concentrated under reduced pressure to give a residue. The residue was purified by prep-HPLC twice (column: Phenomenex Gemini-NX C18, 75×30 mm×3 μm, mobile phase: [water (0.225% FA)-ACN], B %: 12-42, 7 min; column: Phenomenex Luna C18, 150×25 mm×10 m, mobile phase: [water (0.225% FA)-ACN], B %: 19-49, 10 min) to give (2S,4R)-4-hydroxy-1-((S)-2-(2-(2-(4-(2-(((5s,8s)-4-hydroxy-3-mesityl-2-oxo-1-oxaspiro[4.5]dec-3-en-8-yl)oxy)ethyl)piperazin-1-yl)ethoxy)acetamido)-3,3-dimethylbutanoyl)-N—((S)-1-(4-(4-methylthiazol-5-yl)phenyl)ethyl)pyrrolidine-2-carboxamide (30.44 mg, 30.74 μmol, 15.88% yield, 99.9% purity) as a white solid. HNMR: DMSO-d₆, 400 MHz. δ 8.98 (s, 1H), 8.44 (d, J=8.0 Hz, 1H), 8.12 (s, 1H), 7.45-7.35 (m, 5H), 6.74 (s, 2H), 5.26-5.06 (m, 1H), 4.96-4.86 (m, 1H), 4.55 (d, J=9.6 Hz, 1H), 4.48-4.38 (m, 1H), 4.32-4.22 (m, 1H), 4.02-3.90 (m, 2H), 3.68-3.51 (m, 9H), 2.73-2.55 (m, 10H), 2.45 (s, 3H), 2.19 (s, 3H), 2.07-2.01 (m, 7H), 1.99-1.90 (m, 2H), 1.85-1.73 (m, 3H), 1.52-1.43 (m, 4H), 1.40-1.35 (m, 3H), 0.97-0.91 (m, 9H). LCMS: RT=1.991 min, m/z 943.5 [M+H]⁺.

### Example A-18: Synthesis of (2S,4R)-4-hydroxy-1-((S)-2-(2-(2-(4-(2-(((5R,8R)-4-hydroxy-3-mesityl-2-oxo-1-oxa spiro[4.5]dec-3-en-8-yl)oxy)ethyl)piperazin-1-yl)ethoxy)acetamido)-3,3-dimethylbutanoyl)-N—((S)-1-(4-(4-methylthiazol-5-yl)phenyl)ethyl)pyrrolidine-2-carboxamide

### A. Step 1

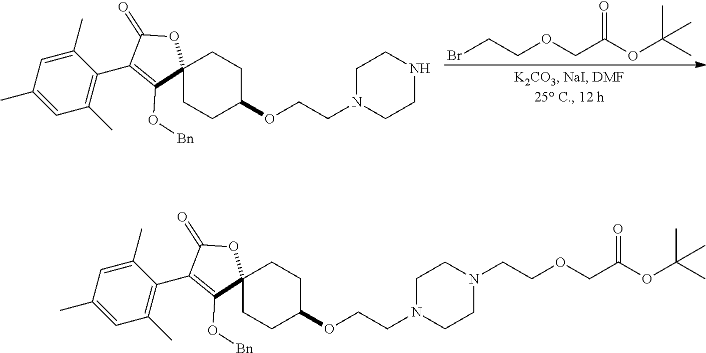

To a mixture of (5r,8r)-4-(benzyloxy)-3-mesityl-8-(2-(piperazin-1-yl)ethoxy)-1-oxaspiro[4.5]dec-3-en-2-one (244 mg, 394.39 μmol, TFA salt; see Example 20, Step 2) and tert-butyl 2-(2-bromoethoxy)acetate (113.16 mg, 473.26 μmol) in DMF (3 mL) were added K₂CO₃ (163.52 mg, 1.18 mmol) and NaI (5.91 mg, 39.44 μmol). The mixture was stirred at 25° C. for 12 hours. The mixture was diluted with H₂O (20 mL) and extracted with EtOAc (20 mL×3). The combined organic layers were washed with brine (20 mL×3), dried over anhydrous Na₂SO₄ and concentrated under reduced pressure to give a residue. The residue was purified by flash chromatography (silica gel, gradient elution from 0 to 5% MeOH in DCM) to give tert-butyl 2-(2-(4-(2-(((5r,8r)-4-(benzyloxy)-3-mesityl-2-oxo-1-oxaspiro[4.5]dec-3-en-8-yl)oxy)ethyl)piperazin-1-yl)ethoxy)acetate (180 mg, 271.55 μmol, 68.85% yield) as a light-yellow oil. HNMR CDCl₃, 400 MHz. δ 7.32-7.27 (m, 3H), 6.97 (dd, J=2.4, 7.6 Hz, 2H), 6.87 (s, 2H), 4.80 (s, 2H), 3.96 (s, 2H), 3.66-3.63 (m, 2H), 3.59 (t, J=6.0 Hz, 2H), 2.66-2.50 (m, 11H), 2.33-2.25 (m, 5H), 2.07-2.04 (m, 6H), 2.03-1.82 (m, 6H), 1.54-1.49 (m, 2H), 1.48-1.46 (m, 9H). LCMS: RT=0.901 min, m/z 663.6 [M+H]⁺.

### B. Step 2

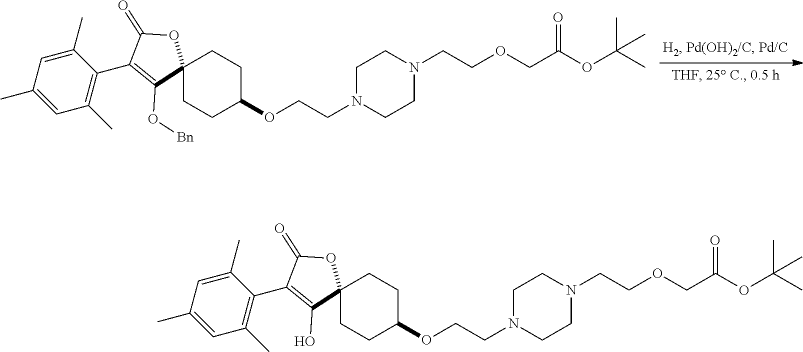

To a mixture of tert-butyl 2-(2-(4-(2-(((5r,8r)-4-(benzyloxy)-3-mesityl-2-oxo-1-oxaspiro[4.5]dec-3-en-8-yl)oxy)ethyl)piperazin-1-yl)ethoxy)acetate (175 mg, 264.01 μmol) in THF (10 mL) were added 10% Pd/C (20 mg) and 20% Pd(OH)₂/C (20 mg) under N₂. The mixture was degassed, purged with H₂ (3×), and stirred at 25° C. for 0.5 hour under 15 psi H₂ (balloon). The mixture was filtered and the filtrate concentrated under reduced pressure to give tert-butyl 2-(2-(4-(2-(((5r,8r)-4-hydroxy-3-mesityl-2-oxo-1-oxaspiro[4.5]dec-3-en-8-yl)oxy)ethyl)piperazin-1-yl)ethoxy)acetate (150 mg, 261.90 μmol, 99.20% yield) as a light-yellow oil, which was used into the next step without further purification. LCMS: RT=0.781 min, m/z 573.2 [M+H]⁺.

### C. Step 3

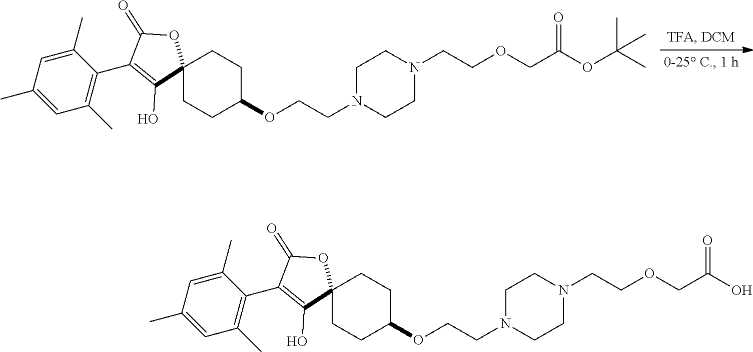

To a mixture of tert-butyl 2-(2-(4-(2-(((5r,8r)-4-hydroxy-3-mesityl-2-oxo-1-oxaspiro[4.5]dec-3-en-8-yl)oxy)ethyl)piperazin-1-yl)ethoxy)acetate (150.00 mg, 261.90 μmol) in DCM (6 mL) was added TFA (5.33 g, 46.75 mmol, 3.46 mL) at 0° C. The mixture was stirred at 25° C. for 1 hour and concentrated under reduced pressure to give 2-(2-(4-(2-(((5r,8r)-4-hydroxy-3-mesityl-2-oxo-1-oxaspiro[4.5]dec-3-en-8-yl)oxy)ethyl)piperazin-1-yl)ethoxy)acetic acid (160 mg, 253.71 μmol, 96.87% yield, TFA salt) as a yellow oil, which was used in the next step without further purification. LCMS: RT=0.743 min, m/z 517.4 [M+H]⁺.

### D. Step 4

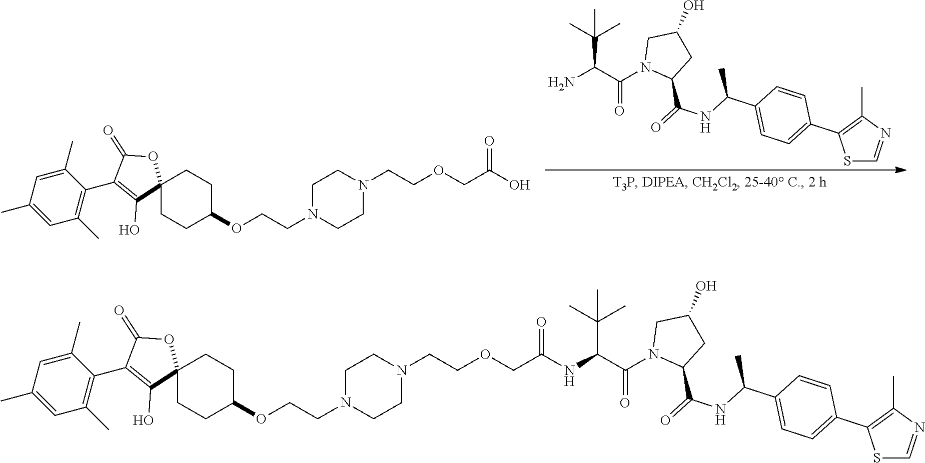

To a mixture of (2S,4R)-1-[(2S)-2-amino-3,3-dimethyl-butanoyl]-4-hydroxy-N-[(1S)-1-[4-(4-methylthiazol-5-yl)phenyl]ethyl]pyrrolidine-2-carboxamide (137.30 mg, 285.42 μmol, HCl salt) and 2-(2-(4-(2-(((5r,8r)-4-hydroxy-3-mesityl-2-oxo-1-oxaspiro[4.5]dec-3-en-8-yl)oxy)ethyl)piperazin-1-yl)ethoxy)acetic acid (150 mg, 237.85 μmol, TFA salt) in DCM (5 mL) were added 50% T₃P (227.04 mg, 356.78 μmol, 212.19 μL) and DIPEA (122.96 mg, 951.40 μmol, 165.71 μL). The mixture was stirred at 25° C. for 1 hour and at 40° C. for 1 hour. The mixture was diluted with H₂O (20 mL) and extracted with EtOAc (20 mL×3). The combined organic layers were washed with brine (20 mL×3), dried over anhydrous Na₂SO₄ and concentrated under reduced pressure to give a residue. The residue was purified by prep-HPLC (column: Phenomenex Luna C18, 75×30 mm×3 μm, mobile phase: [water (0.1% TFA)-ACN], B %: 31-51, 7 min) to give (2S,4R)-4-hydroxy-1-((S)-2-(2-(2-(4-(2-(((5r,8r)-4-hydroxy-3-mesityl-2-oxo-1-oxaspiro[4.5]dec-3-en-8-yl)oxy)ethyl)piperazin-1-yl)ethoxy)acetamido)-3,3-dimethylbutanoyl)-N—((S)-1-(4-(4-methylthiazol-5-yl)phenyl)ethyl)pyrrolidine-2-carboxamide (90.30 mg, 83.11 μmol, 34.94% yield, 97.3% purity, TFA salt) as a white solid. HNMR: DMSO-d₆, 400 MHz. δ 8.99 (s, 1H), 8.41 (d, J=7.6 Hz, 1H), 7.78-7.63 (m, 1H), 7.48-7.41 (m, 2H), 7.41-7.32 (m, 2H), 6.89 (s, 2H), 4.95-4.86 (m, 1H), 4.58-4.54 (m, 1H), 4.44-4.41 (m, 1H), 4.32-4.30 (m, 1H), 4.05 (s, 2H), 3.80-3.69 (m, 6H), 3.65-3.53 (m, 3H), 3.45-3.12 (m, 10H), 2.45 (s, 3H), 2.24 (s, 3H), 2.20-2.10 (m, 2H), 2.05 (s, 7H), 2.00-1.90 (m, 2H), 1.83-1.70 (m, 3H), 1.49-1.34 (m, 5H), 0.98-0.90 (m, 9H). LCMS: RT=2.029 min, m/z 943.5 [M+H]⁺.

### Example A-19: Synthesis of (2S,4R)-4-hydroxy-1-((S)-2-(2-(2-(2-(4-(2-(((5S,8S)-4-hydroxy-3-mesityl-2-oxo-1-oxaspiro[4.5]dec-3-en-8-yl)oxy)ethyl)piperazin-1-yl)ethoxy)ethoxy)acetamido)-3,3-dimethylbutanoyl)-N—((S)-1-(4-(4-methylthiazol-5-yl)phenyl)ethyl)pyrrolidine-2-carboxamide

### A. Step 1

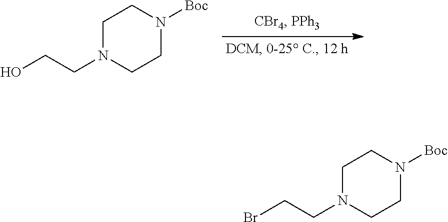 [SMILES: CC(C)(C)OC(=O)N1CCN(CCO)CC1 ; CC(C)(C)OC(=O)N1CCN(CCBr)CC1]

To a solution of tert-butyl 4-(2-hydroxyethyl)piperazine-1-carboxylate (20 g, 86.84 mmol) and PPh₃ (25.06 g, 95.53 mmol) in DCM (100 mL) was added a solution of CBr₄ (31.68 g, 95.53 mmol) in DCM (50 mL) at 0° C. The mixture was stirred at 25° C. for 12 hours and concentrated under reduced pressure to give a residue. The residue was purified by column chromatography (silica gel, gradient elution from 10 to 50% EtOAc in petroleum ether) to give tert-butyl 4-(2-bromoethyl)piperazine-1-carboxylate (13.9 g) as a white solid. HNMR: CDCl₃, 400 MHz. δ 3.40-3.32 (m, 6H), 2.75-2.70 (m, 2H), 2.42-2.36 (m, 4H), 1.39 (s, 9H).

### B. Step 2

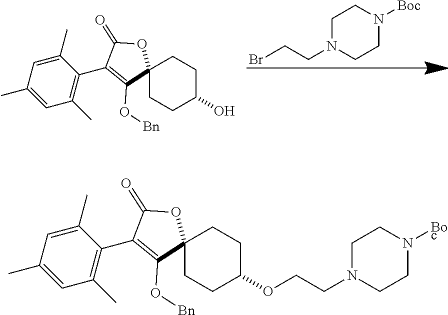

To a solution of (5s,8s)-4-(benzyloxy)-8-hydroxy-3-mesityl-1-oxaspiro[4.5]dec-3-en-2-one (1.00 g, 2.55 mmol; see Example 7, Step 10), TBAB (164.27 mg, 509.57 μmol) and tert-butyl 4-(2-bromoethyl)piperazine-1-carboxylate (2.24 g, 7.64 mmol) in xylene (15 mL) were added KOH (714.75 mg, 12.74 mmol). The mixture was stirred at 50° C. for 12 hours. The reaction mixture was filtered and concentrated under reduced pressure to give a residue. The residue was purified by column chromatography (silica gel, gradient elution from 10 to 50% EtOAc in petroleum ether) to give tert-butyl 4-(2-(((5s,8s)-4-(benzyloxy)-3-mesityl-2-oxo-1-oxaspiro[4.5]dec-3-en-8-yl)oxy)ethyl)piperazine-1-carboxylate (2.2 g, 3.64 mmol, 71.39% yield) as a brown solid. HNMR: CDCl₃, 400 MHz. δ 7.26-7.20 (m, 3H), 6.96-6.91 (m, 2H), 6.81 (s, 2H), 4.69 (s, 2H), 3.56 (t, J=6.0 Hz, 2H), 3.39-3.35 (m, 4H), 2.76-2.71 (m, 1H), 2.54 (t, J=6.0 Hz, 2H), 2.41-2.37 (m, 4H), 2.22 (s, 3H), 2.02 (s, 6H), 2.00-1.87 (m, 4H), 1.77-1.64 (m, 4H), 1.39 (s, 9H). LCMS: RT=0.914 min, m/z 605.4 [M+H]⁺.

### C. Step 3

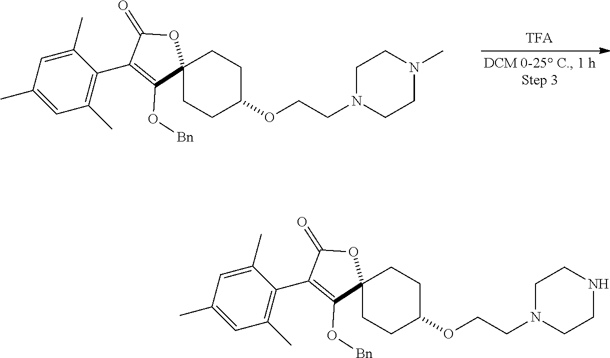

To a solution of tert-butyl 4-(2-(((5s,8s)-4-(benzyloxy)-3-mesityl-2-oxo-1-oxaspiro[4.5]dec-3-en-8-yl)oxy)ethyl)piperazine-1-carboxylate (2.00 g, 3.31 mmol) in DCM (20 mL) was dropwise added TFA (4 mL) at 0° C. The mixture was stirred at 25° C. for 1 hour. The reaction mixture was concentrated under reduced pressure to give (5s,8s)-4-(benzyloxy)-3-mesityl-8-(2-(piperazin-1-yl)ethoxy)-1-oxaspiro[4.5]dec-3-en-2-one (3.2 g, crude, TFA salt) as a brown solid. HNMR: CDCl₃, 400 MHz. δ 7.36-7.27 (m, 4H), 6.98-6.94 (m, 2H), 6.90 (s, 2H), 4.79 (s, 2H), 3.86-3.62 (m, 10H), 3.44-3.33 (m, 3H), 2.30 (s, 3H), 2.07-2.01 (m, 8H), 2.01-1.94 (m, 2H), 1.84-1.75 (m, 2H), 1.69-1.60 (m, 2H). LCMS: RT=0.836 min, m/z 505.4 [M+H]⁺.

### D. Step 4

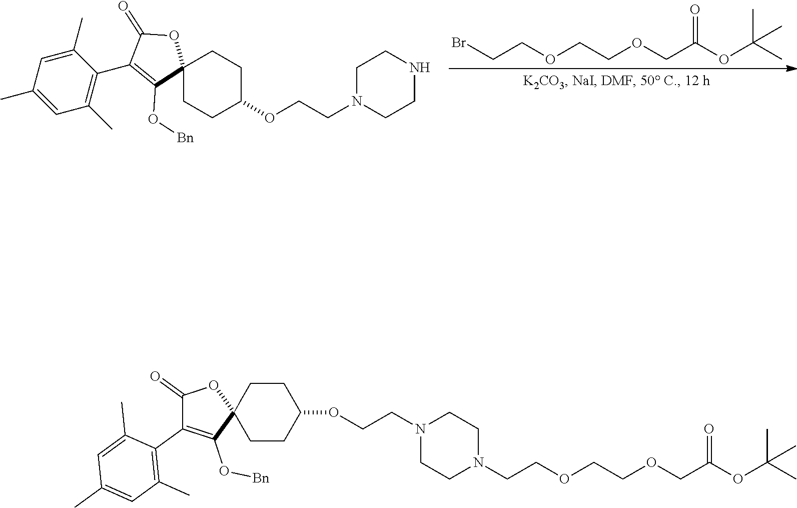

To a mixture of (5s,8s)-4-(benzyloxy)-3-mesityl-8-(2-(piperazin-1-yl)ethoxy)-1-oxaspiro[4.5]dec-3-en-2-one (200 mg, 323.27 μmol, TFA salt) in DMF (5 mL) were added tert-butyl 2-[2-(2-bromoethoxy)ethoxy]acetate (137.30 mg, 484.90 μmol), K₂CO₃ (134.04 mg, 969.80 μmol) and NaI (48.45 mg, 323.27 μmol). The mixture was stirred at 50° C. for 12 hours. EtOAc (10 mL) and water (20 mL) were added. The aqueous phase was extracted with EtOAc (10 mL×3). Combined extracts were washed with brine (20 mL), dried over Na₂SO₄, filtered, and concentrated at reduced pressure. The residue was purified by column chromatography (silica gel, gradient elution from 50:1 to 20:1 DCM:MeOH) to tert-butyl 2-(2-(2-(4-(2-(((5s,8s)-4-(benzyloxy)-3-mesityl-2-oxo-1-oxaspiro[4.5]dec-3-en-8-yl)oxy)ethyl)piperazin-1-yl)ethoxy)ethoxy)acetate (110 mg, 155.61 μmol, 48.14% yield) as a colorless oil. LCMS: RT=0.737 min, m/z 707.4 [M+H]⁺.

### E. Step 5

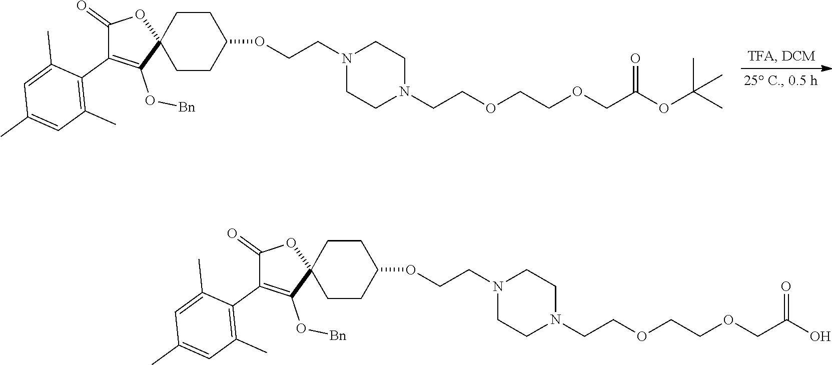

To a mixture of tert-butyl 2-(2-(2-(4-(2-(((5s,8s)-4-(benzyloxy)-3-mesityl-2-oxo-1-oxaspiro[4.5]dec-3-en-8-yl)oxy)ethyl)piperazin-1-yl)ethoxy)ethoxy)acetate (110 mg, 155.61 μmol) in DCM (2 mL) was added TFA (3.08 g, 27.01 mmol, 2 mL). The mixture was stirred at 25° C. for 0.5 hour and then concentrated to dryness at reduced pressure to afford 2-(2-(2-(4-(2-(((5s,8s)-4-(benzyloxy)-3-mesityl-2-oxo-1-oxaspiro[4.5]dec-3-en-8-yl)oxy)ethyl)piperazin-1-yl)ethoxy)ethoxy)acetic acid (100 mg, crude) as a yellow oil, which was used in the next step without further purification. LCMS: RT=0.866 min, m/z 651.5 [M+H]⁺.

### F. Step 6

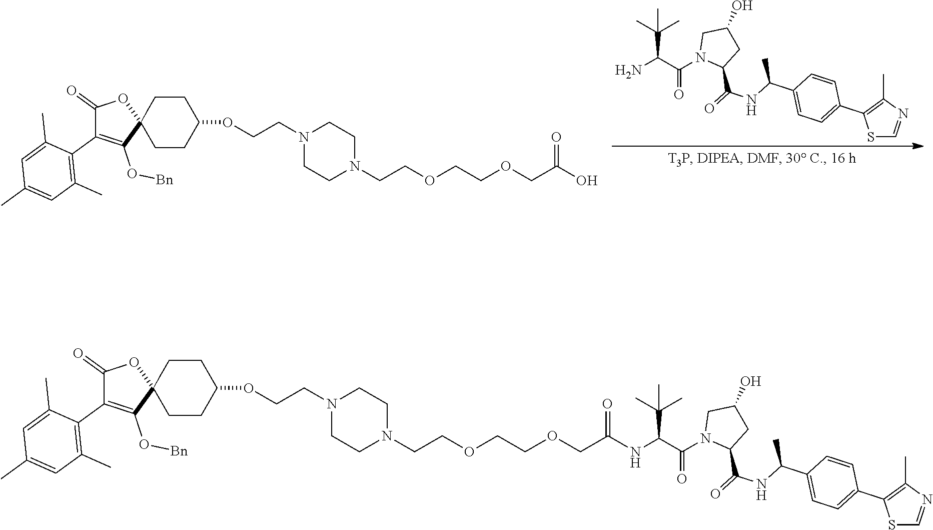

To a mixture of 2-(2-(2-(4-(2-(((5s,8s)-4-(benzyloxy)-3-mesityl-2-oxo-1-oxaspiro[4.5]dec-3-en-8-yl)oxy)ethyl)piperazin-1-yl)ethoxy)ethoxy)acetic acid (100 mg, 153.66 μmol, crude) in DCM (5 mL) were added (2S,4R)-1-[(2S)-2-amino-3,3-dimethyl-butanoyl]-4-hydroxy-N-[(1S)-1-[4-(4-methylthiazol-5-yl)phenyl]ethyl]pyrrolidine-2-carboxamide (73.92 mg, 153.66 μmol, HCl salt), 50% T₃P (146.67 mg, 460.97 μmol, 137.08 μL) and DIPEA (158.87 mg, 1.23 mmol, 214.11 μL). The mixture was stirred at 30° C. for 16 hours. EtOAc (20 mL) and water (20 mL) were added, and the phases separated. The aqueous phase was extracted with EtOAc (30 mL×3). The combined organic extracts were washed with brine (20 mL), dried over Na₂SO₄, filtered, and concentrated under vacuum to give a residue. The residue was purified by prep-TLC (silica gel, 10:1 DCM:MeOH) to give (2S,4R)-1-((S)-2-(2-(2-(2-(4-(2-(((5s,8s)-4-(benzyloxy)-3-mesityl-2-oxo-1-oxaspiro[4.5]dec-3-en-8-yl)oxy)ethyl)piperazin-1-yl)ethoxy)ethoxy)acetamido)-3,3-dimethylbutanoyl)-4-hydroxy-N—((S)-1-(4-(4-methylthiazol-5-yl)phenyl)ethyl)pyrrolidine-2-carboxamide (45 mg, 41.77 μmol, 27.18% yield) as a colorless oil. LCMS: RT=0.915 min, m/z 1077.3 [M+H]⁺.

### G. Step 7

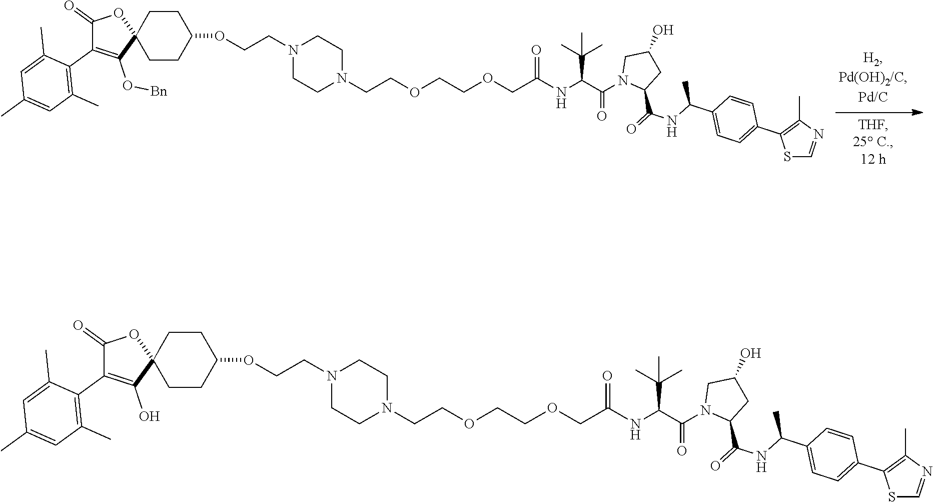

To a mixture of (2S,4R)-1-((S)-2-(2-(2-(2-(4-(2-(((5s,8s)-4-(benzyloxy)-3-mesityl-2-oxo-1-oxaspiro[4.5]dec-3-en-8-yl)oxy)ethyl)piperazin-1-yl)ethoxy)ethoxy)acetamido)-3,3-dimethylbutanoyl)-4-hydroxy-N—((S)-1-(4-(4-methylthiazol-5-yl)phenyl)ethyl)pyrrolidine-2-carboxamide (45 mg, 41.77 μmol) in MeOH (5 mL) was added 10% Pd/C (20 mg) and 10% Pd(OH)₂/C (50 mg) under N₂. The mixture was degassed, purged with H₂ (3×) and stirred at 25° C. for 12 hours under 15 psi H₂ (balloon). After removal of the catalyst by filtration, the filtrate was evaporated under reduced pressure. The crude product was purified by prep-HPLC (column: Phenomenex Luna C18, 150×25 mm×10 μm, mobile phase: [water (0.225% FA)-ACN], B %: 19-49, 10 min) to give (2S,4R)-4-hydroxy-1-((S)-2-(2-(2-(2-(4-(2-(((5s,8s)-4-hydroxy-3-mesityl-2-oxo-1-oxaspiro[4.5]dec-3-en-8-yl)oxy)ethyl)piperazin-1-yl)ethoxy)ethoxy)acetamido)-3,3-dimethylbutanoyl)-N—((S)-1-(4-(4-methylthiazol-5-yl)phenyl)ethyl)pyrrolidine-2-carboxamide (7.66 mg, 7.76 μmol, 18.58% yield, 99.9% purity) as a white solid. HNMR: DMSO-d₆, 400 MHz. δ 8.99 (s, 1H), 8.48-8.40 (m, 1H), 8.14 (s, 1H), 7.44-7.36 (m, 4H), 6.81-6.67 (m, 2H), 5.22-5.13 (m, 1H), 4.93-4.85 (m, 1H), 4.58-4.51 (m, 1H), 4.46-4.40 (m, 1H), 4.31-4.23 (m, 1H), 3.97 (s, 2H), 3.66-3.55 (m, 9H), 3.17-2.70 (m, 10H), 2.46-2.43 (m, 6H), 2.20 (s, 3H), 2.04-1.81 (m, 14H), 1.54-1.36 (m, 7H), 0.96-0.91 (m, 9H). LCMS: RT=1.967 min, m/z 987.5 [M+H]⁺.

### Example A-20: Synthesis of (2S,4R)-4-hydroxy-1-((S)-2-(2-(2-(2-(4-(2-(((5R,8R)-4-hydroxy-3-mesityl-2-oxo-1-oxaspiro[4.5]dec-3-en-8-yl)oxy)ethyl)piperazin-1-yl)ethoxy)ethoxy)acetamido)-3,3-dimethylbutanoyl)-N—((S)-1-(4-(4-methylthiazol-5-yl)phenyl)ethyl)pyrrolidine-2-carboxamide

### A. Step 1

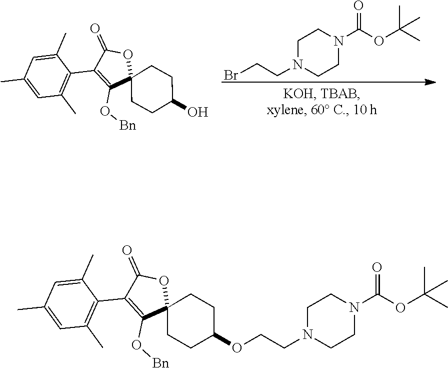 [SMILES: Cc1cc(C)c(C2=C(OCc3ccccc3)[C@]3(CC[C@@H](O)CC3)OC2=O)c(C)c1 ; CC(C)(C)OC(=O)N1CCN(CCBr)CC1 ; Cc1cc(C)c(C2=C(OCc3ccccc3)[C@]3(CC[C@@H](OCCN4CCN(C(=O)OC(C)(C)C)CC4)CC3)OC2=O)c(C)c1]

A mixture of (5r,8r)-4-(benzyloxy)-8-hydroxy-3-mesityl-1-oxaspiro[4.5]dec-3-en-2-one (500 mg, 1.27 mmol; prepared using general methods described herein for the preparation of (5s,8s)-4-(benzyloxy)-8-hydroxy-3-mesityl-1-oxaspiro[4.5]dec-3-en-2-one), tertbutyl 4-(2-bromoethyl)piperazine-1-carboxylate (934 mg, 3.19 mmol), TBAB (205 mg, 635.92 μmol) and KOH (357 mg, 6.36 mmol) in xylene (10 mL) was stirred at 60° C. for 10 hours under microwave irradiation. The mixture was diluted with water (50 mL) and extracted with EtOAc (20 mL×2). The combined organic phases were washed with brine (50 mL), dried over anhydrous Na₂SO₄, filtered and concentrated to give a residue. The residue was purified by column chromatography (silica gel, gradient elution from 10 to 100% EtOAc in petroleum ether) to give tert-butyl 4-(2-(((5r,8r)-4-(benzyloxy)-3-mesityl-2-oxo-1-oxaspiro[4.5]dec-3-en-8-yl)oxy)ethyl)piperazine-1-carboxylate (600 mg, 972.26 μmol, 38.16% yield, 98% purity) as a yellow solid. HNMR: CDCl₃, 400 MHz. δ 7.24-7.18 (m, 3H), 6.93-6.86 (m, 2H), 6.81-6.77 (m, 2H), 4.74-4.71 (m, 2H), 3.63-3.58 (m, 1H), 3.57-3.50 (m, 2H), 3.39-3.30 (m, 4H), 2.63-2.54 (m, 2H), 2.53-2.36 (m, 4H), 2.26-2.15 (m, 5H), 1.99-1.83 (m, 10H), 1.49-1.42 (m, 2H), 1.39-1.35 (m, 9H). LCMS: RT=0.847 min, m/z 605.4 [M+H]⁺.

### B. Step 2

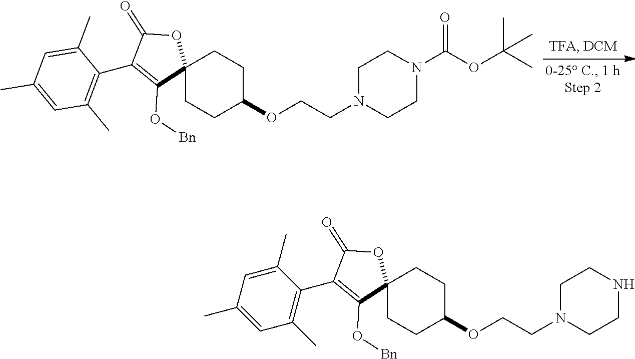

To a mixture of tert-butyl 4-(2-(((5r,8r)-4-(benzyloxy)-3-mesityl-2-oxo-1-oxaspiro[4.5]dec-3-en-8-yl)oxy)ethyl)piperazine-1-carboxylate (650 mg, 1.07 mmol) in DCM (5 mL) was added TFA (3.08 g, 27.01 mmol, 2 mL) at 0° C. Then the mixture was stirred at 25° C. for 1 hour and concentrated in vacuo to give (5r,8r)-4-(benzyloxy)-3-mesityl-8-(2-(piperazin-1-yl)ethoxy)-1-oxaspiro[4.5]dec-3-en-2-one (660 mg, crude, TFA salt) as a yellow oil, which was used in the next step without further purification. LCMS: RT=0.807 min, m/z 505.2 [M+H]⁺.

### C. Step 3

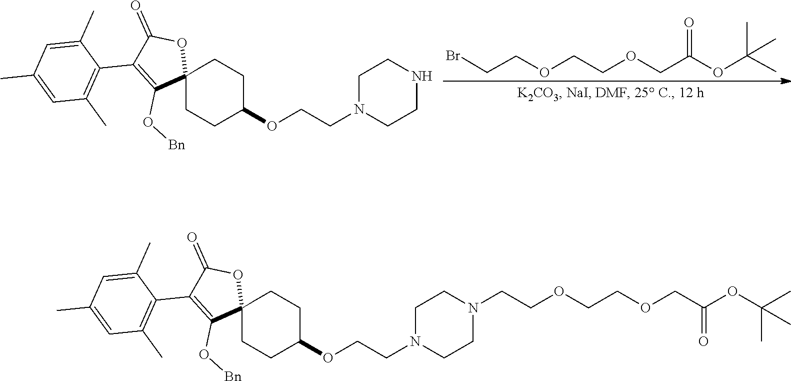

To the mixture of (5r,8r)-4-(benzyloxy)-3-mesityl-8-(2-(piperazin-1-yl)ethoxy)-1-oxaspiro[4.5]dec-3-en-2-one (244 mg, 394.39 μmol, TFA) and tert-butyl 2-(2-(2-bromoethoxy)ethoxy)acetate (134.01 mg, 473.26 μmol) in DMF (2 mL) were added K₂CO₃ (218.03 mg, 1.58 mmol) and NaI (5.91 mg, 39.44 μmol). The mixture was stirred at 25° C. for 12 hours. To the reaction mixture were added water (10 mL) and EtOAc (20 mL) and the phases separated. The aqueous phase was extracted with EtOAc (30 mL×3). The combined organic phases were washed with brine (30 mL×3), dried over Na₂SO₄, filtered, and concentrated in vacuum. The residue was purified by prep-TLC (silica gel, 10:1 DCM:MeOH) to give tert-butyl 2-(2-(2-(4-(2-(((5r,8r)-4-(benzyloxy)-3-mesityl-2-oxo-1-oxaspiro[4.5]dec-3-en-8-yl)oxy)ethyl)-piperazin-1-yl)ethoxy)ethoxy)acetate (200 mg, 282.92 μmol, 71.74% yield) as a dark-brown oil. LCMS: RT=0.802 min, m/z=707.2 [M+H]⁺.

### D. Step 4

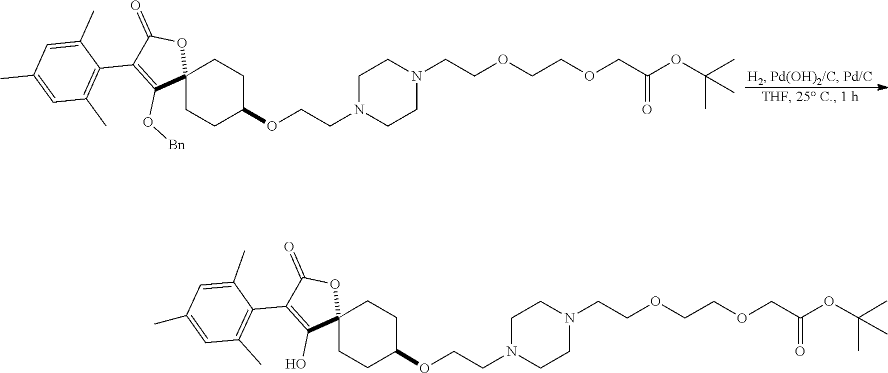

To the mixture of tert-butyl 2-(2-(2-(4-(2-(((5r,8r)-4-(benzyloxy)-3-mesityl-2-oxo-1-oxaspiro[4.5]dec-3-en-8-yl)oxy)ethyl)piperazin-1-yl)ethoxy)ethoxy)acetate (200 mg, 282.92 μmol) in THF (5 mL) were added 10% Pd/C (100 mg) and 20% Pd(OH)₂/C (50 mg) under N₂. The mixture was degassed, purged with H₂ (3×) and stirred at 25° C. for 1 hour under 15 psi H₂ (balloon). The mixture was filtered and the filtrate concentrated in vacuum to give tert-butyl 2-(2-(2-(4-(2-(((5r,8r)-4-hydroxy-3-mesityl-2-oxo-1-oxaspiro[4.5]dec-3-en-8-yl)oxy)ethyl)piperazin-1-yl)ethoxy)ethoxy)acetate (157 mg, crude) as a darkbrown oil, which was used in the next step without further purification. LCMS: RT=0.791 min, m/z=617.3 [M+H]⁺.

### E. Step 5

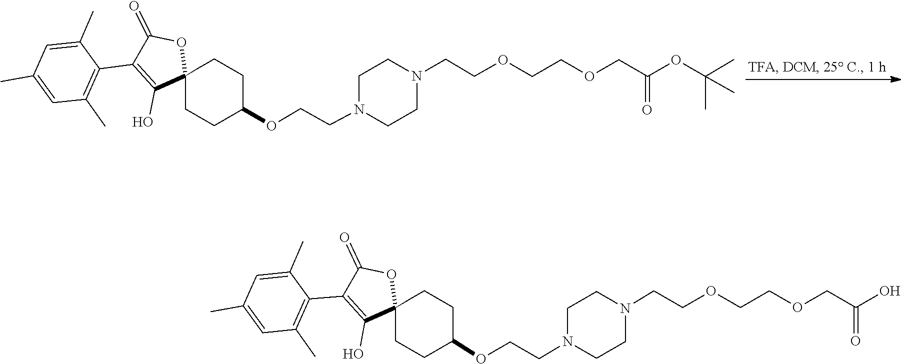

The mixture of tert-butyl 2-(2-2-(4-(2-(((5r,8r)-4-hydroxy-3-mesityl-2-oxo-1-oxaspiro[4.5]dec-3-en-8-yl)oxy)ethyl)piperazin-1-yl)ethoxy)ethoxy)acetate (157 mg, 254.55 μmol) in TFA (1.54 g, 13.51 mmol, 1 mL) and DCM (3 mL) was stirred at 25° C. for 1 hour. The reaction was concentrated in vacuum to 2-(2-(2-(4-(2-(((5r,8r)-4-hydroxy-3-mesityl-2-oxo-1-oxaspiro[4.5]dec-3-en-8-yl)oxy)ethyl)piperazin-1-yl)ethoxy)ethoxy)acetic acid (171 mg, crude, TFA) as a dark-brown oil, which was used in the next step without further purification. LCMS: RT=0.735 min, m/z=561.4 [M+H]⁺.

### F. Step 6

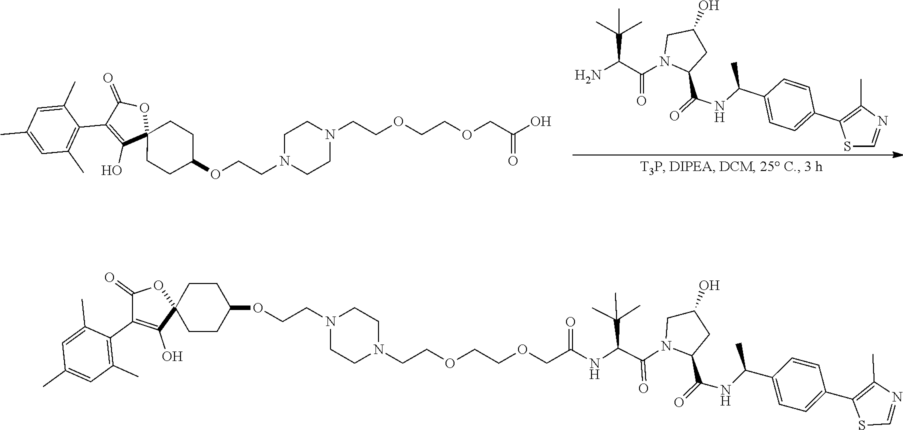

To a mixture of 2-(2-(2-(4-(2-(((5r,8r)-4-hydroxy-3-mesityl-2-oxo-1-oxaspiro[4.5]dec-3-en-8-yl)oxy)ethyl)piperazin-1-yl)ethoxy)ethoxy)acetic acid (171 mg, 304.99 μmol) and (2S,4R)-1-((S)-2-amino-3,3-dimethylbutanoyl)-4-hydroxy-N—((S)-1-(4-(4-methylthiazol-5-yl)phenyl)ethyl)pyrrolidine-2-carboxamide (190.73 mg, 396.48 μmol, HCl salt) in DCM (5 mL) were added DIPEA (275.92 mg, 2.13 mmol, 371.86 μL) and 50% T₃P (232.90 mg, 365.99 μmol, 217.66 μL). The mixture was stirred at 25° C. for 3 hours. The reaction was concentrated in vacuum the residue purified by prep-HPLC (column: Waters Xbridge, 150×25 mm×5 m, mobile phase: [water (10 mM NH₄HCO₃)-ACN], B %: 20-50, 10 min) to give (2S,4R)-4-hydroxy-1-((S)-2-(2-(2-(2-(4-(2-(((5r,8r)-4-hydroxy-3-mesityl-2-oxo-1-oxaspiro[4.5]dec-3-en-8-yl)oxy)ethyl)piperazin-1-yl)ethoxy)ethoxy)acetamido)-3,3-dimethylbutanoyl)-N—((S)-1-(4-(4-methyl-thiazol-5-yl)phenyl)ethyl)pyrrolidine-2-carboxamide (150.84 mg, 152.79 μmol, 50.10% yield, 99.9% purity) as a white solid. HNMR: DMSO-d₆, 400 MHz. δ 9.01-8.94 (m, 1H), 8.47-8.37 (m, 1H), 7.48-7.29 (m, 5H), 6.77 (s, 2H), 4.94-4.84 (m, 1H), 4.58-4.50 (m, 1H), 4.46-4.38 (m, 1H), 4.28-4.22 (m, 1H), 3.96-3.81 (m, 2H), 3.63-3.54 (m, 13H), 2.76-2.54 (m, 10H), 2.45 (s, 3H), 2.19 (s, 3H), 2.09-1.98 (m, 9H), 1.90-1.82 (m, 2H), 1.78-1.63 (m, 3H), 1.48-1.33 (m, 3H), 1.30-1.21 (m, 2H), 0.96-0.89 (m, 9H). LCMS: RT=2.029 min, m/z=987.5 [M+H]⁺.

### Example A-21: Synthesis of (2S,4R)-4-hydroxy-1-((S)-2-(2-(2-(4-(2-(2-(((5S,8S)-4-hydroxy-3-mesityl-2-oxo-1-oxaspiro[4.5]dec-3-en-8-yl)oxy)ethoxy)ethyl)piperazin-1-yl)ethoxy)acetamido)-3,3-dimethylbutanoyl)-N—((S)-1-(4-(4-methylthiazol-5-yl)phenyl)ethyl)pyrrolidine-2-carboxamide

### A. Step 1

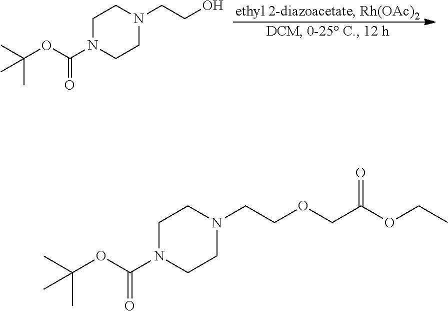 [SMILES: CC(C)(C)OC(=O)N1CCN(CCO)CC1 ; CCOC(=O)COCCN1CCN(C(=O)OC(C)(C)C)CC1]

To a mixture of tert-butyl 4-(2-hydroxyethyl) piperazine-1-carboxylate (1 g, 4.34 mmol) in DCM (10 mL) was added Rh(OAc)₂ (96 mg, 434.40 μmol). The mixture was degassed and purged with nitrogen (3×). Then a solution of ethyl 2-diazoacetate (991 mg, 8.69 mmol) in DCM (10 mL) was added slowly at 0° C. The mixture was then stirred at 25° C. for 12 hours under nitrogen. The mixture was diluted with water (50 mL) and extracted with DCM (20 mL×2). The combined organic phases were washed with brine (100 mL), dried over Na₂SO₄, filtered, and concentrated to give a residue. The residue was purified by column chromatography (silica gel, gradient elution from 0-25% EtOAc in petroleum ether) to give tert-butyl 4-[2-(2-ethoxy-2-oxo-ethoxy) ethyl]piperazine-1-carboxylate (600 mg, 1.90 mmol, 43.67% yield) as a yellow oil. HNMR: CDCl₃, 400 MHz. δ 4.20-4.27 (m, 2H), 4.12-4.13 (m, 2H), 3.71 (t, J=5.6 Hz, 2H), 3.44-3.51 (m, 4H), 2.66 (t, J=5.6 Hz, 2H), 2.44-2.52 (m, 4H), 1.48 (s, 9H), 1.31 (t, J=7.2 Hz, 3H). LCMS: RT=0.629 min, m/z 317.1 [M+H]⁺.

### B. Step 2

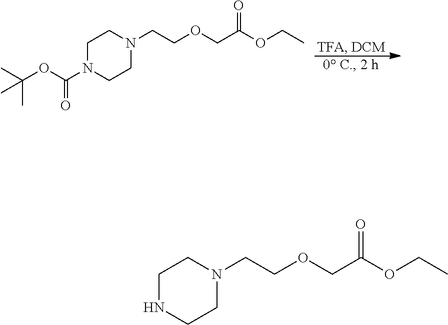 [SMILES: CCOC(=O)COCCN1CCN(C(=O)OC(C)(C)C)CC1 ; CCOC(=O)COCCN1CCNCC1]

To a mixture of tert-butyl 4-[2-(2-ethoxy-2-oxo-ethoxy)ethyl]piperazine-1-carboxylate (600 mg, 1.90 mmol) in DCM (6 mL) was added TFA (3.08 g, 27.01 mmol, 2 mL) at 0° C. The mixture was then stirred at 0° C. for 2 hours. The mixture was concentrated to give ethyl 2-(2-piperazin-1-ylethoxy)acetate (0.63 g, crude, TFA salt) as a brown oil. HNMR: CDCl₃, 400 MHz. δ 4.21 (s, 2H), 4.11-4.19 (m, 2H), 3.79-3.87 (m, 2H), 3.35-3.57 (m, 10H), 1.22 (t, J=7.2 Hz, 3H). LCMS: RT=0.729 min, m/z 217.1 [M+H]⁺.

### C. Step 3

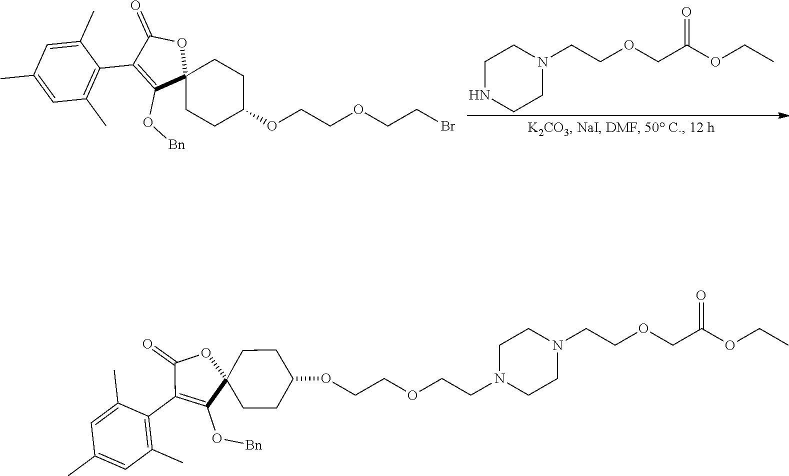 [SMILES: Cc1cc(C)c(C2=C(OCc3ccccc3)[C@]3(CC[C@H](OCCOCCBr)CC3)OC2=O)c(C)c1 ; CCOC(=O)COCCN1CCNCC1 ; CCOC(=O)COCCN1CCN(CCOCCO[C@H]2CC[C@]3(CC2)OC(=O)C(c2c(C)cc(C)cc2C)=C3OCc2ccccc2)CC1]

To a solution of (5s,8s)-4-(benzyloxy)-8-(2-(2-bromoethoxy)ethoxy)-3-mesityl-1-oxaspiro[4.5]dec-3-en-2-one (300.00 mg, 551.99 μmol; prepared from (5s,8s)-4-(benzyloxy)-8-hydroxy-3-mesityl-1-oxaspiro[4.5]dec-3-en-2-one using general methods described herein for the preparation of (5r,8r)-4-(benzyloxy)-8-(2-(2-bromoethoxy)ethoxy)-3-mesityl-1-oxaspiro[4.5]dec-3-en-2-one) and ethyl 2-(2-piperazin-1-ylethoxy)acetate (364.64 mg, 1.10 mmol, TFA salt) in DMF (3 mL) were added K₂CO₃ (381.44 mg, 2.76 mmol) and NaI (82.74 mg, 551.99 μmol). The mixture was stirred at 50° C. for 12 hours, diluted with EtOAc (50 mL) and washed with water (50 mL×2) followed by brine (50 mL×2). The organic phase was dried over anhydrous Na₂SO₄, filtered and concentrated in vacuo to give a residue. The residue was purified by prep-TLC (silica gel, 10:1 DCM:MeOH) to give ethyl 2-(2-(4-(2-(2-(((5s,8s)-4-(benzyloxy)-3-mesityl-2-oxo-1-oxaspiro[4.5]dec-3-en-8-yl)oxy)ethoxy)ethyl)piperazin-1-yl)ethoxy)acetate (0.3 g, 441.92 μmol, 80.06% yield) as a yellow oil. HNMR: CDCl₃, 400 MHz. δ 7.32-7.30 (m, 3H), 7.02-7.01 (m, 2H), 6.88 (s, 2H), 5.31 (s, 2H), 4.76 (s, 2H), 4.21 (q, J=7.2 Hz, 2H), 4.10 (s, 2H), 3.70-3.61 (m, 8H), 3.42-3.39 (m, 1H), 2.69-2.66 (m, 10H), 2.29 (s, 3H), 2.09 (s, 6H), 2.09-1.97 (m, 4H), 1.83-1.80 (m, 4H), 1.29 (t, J=7.2 Hz, 3H). LCMS: RT=0.780 min, m/z 679.2 [M+H]⁺.

### D. Step 4

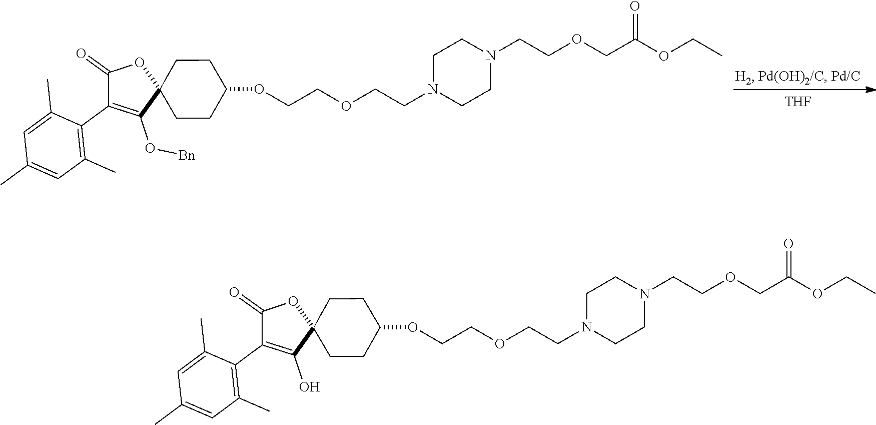

To a mixture of ethyl 2-(2-(4-(2-(2-(((5s,8s)-4-(benzyloxy)-3-mesityl-2-oxo-1-oxaspiro[4.5]dec-3-en-8-yl)oxy)ethoxy)ethyl)piperazin-1-yl)ethoxy)acetate (0.28 g, 412.46 μmol) in THE (3 mL) was added 20% Pd(OH)₂/C (20 mg) and 10% Pd/C (100 mg). The mixture was degassed, purged with H₂ (3×), and stirred at 25° C. for 1 hour under 15 psi H₂. The mixture was diluted with MeOH (10 mL), filtered, and the filtrate concentrated at reduced pressure to afford ethyl 2-(2-(4-(2-(2-(((5s,8s)-4-hydroxy-3-mesityl-2-oxo-1-oxaspiro[4.5]dec-3-en-8-yl)oxy)ethoxy)ethyl)piperazin-1-yl)ethoxy)acetate (0.23 g, crude) as a yellow solid, which was in the next step without further purification. LCMS: RT=0.680 min, m/z 589.2 [M+H]⁺.

### E. Step 5

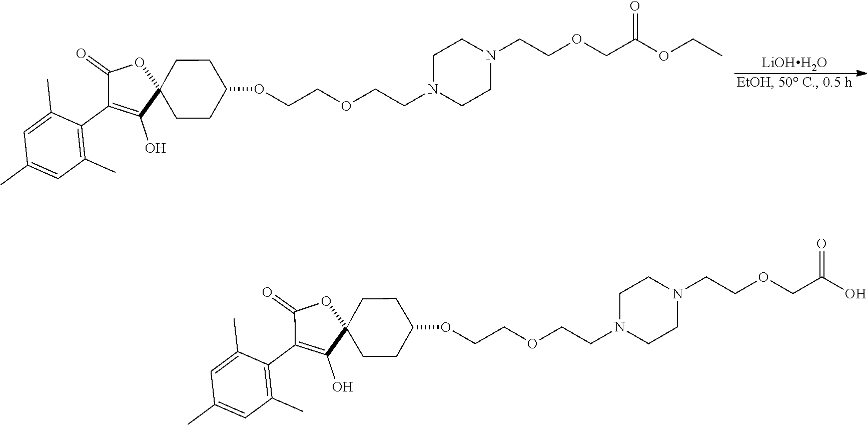

To a stirred mixture of ethyl 2-(2-(4-(2-(2-(((5s,8s)-4-hydroxy-3-mesityl-2-oxo-1-oxaspiro[4.5]dec-3-en-8-yl)oxy)ethoxy)ethyl)piperazin-1-yl)ethoxy)acetate (230.00 mg, 390.67 μmol) in EtOH (1 mL) and H₂O (0.5 mL) was added LiOH H₂O (81.96 mg, 1.95 mmol). The mixture was stirred at 50° C. for 10 minutes. The mixture was concentrated, and the residue acidified to pH-3 by addition of 2M aqueous HCl. The resulting mixture was concentrated to dryness at reduced pressure to afford 2-(2-(4-(2-(2-(((5s,8s)-4-hydroxy-3-mesityl-2-oxo-1-oxaspiro[4.5]dec-3-en-8-yl)oxy)ethoxy)ethyl)piperazin-1-yl)ethoxy)acetic acid (0.22 g, crude) as a white solid, which was used in the next step without further purification. LCMS: RT=0.642 min, m/z 561.2 [M+H]⁺.

### F. Step 6

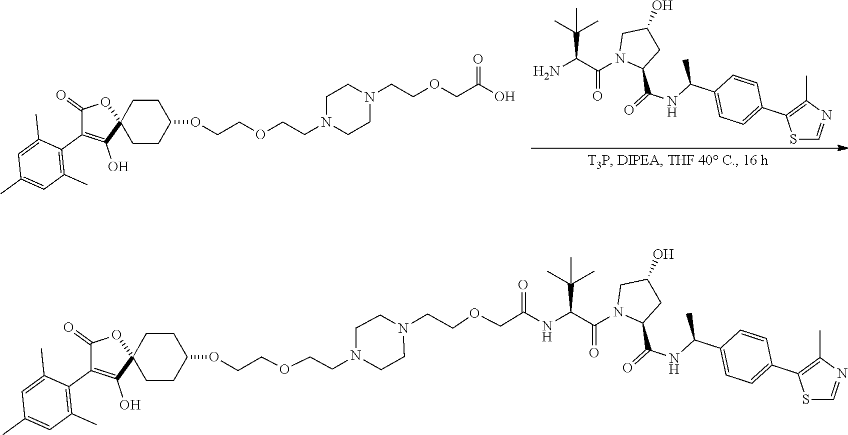

To a stirred mixture of 2-(2-(4-(2-(2-(((5s,8s)-4-hydroxy-3-mesityl-2-oxo-1-oxaspiro[4.5]dec-3-en-8-yl)oxy)ethoxy)ethyl)piperazin-1-yl)ethoxy)acetic acid (0.2 g, 356.71 μmol), (2S,4R)-1-[(2S)-2-amino-3,3-dimethylbutanoyl]-4-hydroxy-N-[(1S)-1-[4-(4-methylthiazol-5-yl)phenyl]ethyl]pyrrolidine-2-carboxamide (257.39 mg, 535.07 μmol, HCl salt) in THF (2 mL) was added 50% T₃P (680.99 mg, 1.07 mmol, 636.44 μL) and DIPEA (368.81 mg, 2.85 mmol, 497.05 μL). The mixture was stirred at 40° C. for 16 hours. The mixture was concentrated and the residue purified by prep-HPLC (column: Phenomenex Gemini-NX C18, 75×30 mm×3 μm, mobile phase: [water (0.05% ammonium hydroxide v/v)-ACN], B %: 5-35, 8 min) to afford (2S,4R)-4-hydroxy-1-((S)-2-(2-(2-(4-(2-(2-(((5s,8s)-4-hydroxy-3-mesityl-2-oxo-1-oxaspiro[4.5]dec-3-en-8-yl)oxy)ethoxy)ethyl)piperazin-1-yl)ethoxy)acetamido)-3,3-dimethylbutanoyl)-N—((S)-1-(4-(4-methyl-thiazol-5-yl)phenyl)ethyl)pyrrolidine-2-carboxamide (47.38 mg, 46.55 μmol, 13.05% yield, 97.0% purity) as a yellow solid. HNMR: CD³OD, 400 MHz. δ 8.90 (s, 1H), 7.48-7.39 (m, 4H), 6.83 (s, 2H), 5.03 (q, J=7.2 Hz, 1H), 4.61-4.57 (m, 3H), 4.46-4.41 (m, 1H), 4.11-4.08 (m, 2H), 3.85-3.68 (m, 11H), 3.50-3.45 (m, 1H), 3.25-2.93 (m, 10H), 2.50 (s, 3H), 2.23 (s, 3H), 2.16 (s, 6H), 2.16-1.97 (m, 5H), 1.72-1.69 (m, 4H), 1.54-1.52 (m, 3H), 1.40-1.38 (m, 1H), 1.06 (d, J=5.6 Hz, 9H). LCMS: RT=1.991 min, m/z 987.5 [M+H]⁺.

### Example A-22: Synthesis of (2S,4R)-4-hydroxy-1-((S)-2-(2-(2-(4-(2-(2-(((5R,8R)-4-hydroxy-3-mesityl-2-oxo-1-oxaspiro[4.5]dec-3-en-8-yl)oxy)ethoxy)ethyl)piperazin-1-yl)ethoxy)acetamido)-3,3-dimethylbutanoyl)-N—((S)-1-(4-(4-methylthiazol-5-yl)phenyl)ethyl)pyrrolidine-2-carboxamide

### A. Step 1

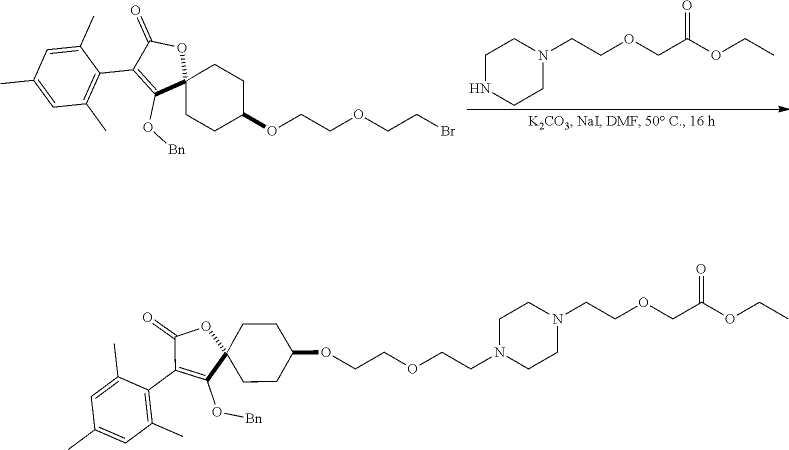 [SMILES: Cc1cc(C)c(C2=C(OCc3ccccc3)[C@]3(CC[C@@H](OCCOCCBr)CC3)OC2=O)c(C)c1 ; CCOC(=O)COCCN1CCNCC1 ; CCOC(=O)COCCN1CCN(CCOCCO[C@H]2CC[C@@]3(CC2)OC(=O)C(c2c(C)cc(C)cc2C)=C3OCc2ccccc2)CC1]

To a solution of (5r,8r)-4-(benzyloxy)-8-(2-(2-bromoethoxy)ethoxy)-3-mesityl-1-oxaspiro[4.5]dec-3-en-2-one (180 mg, 331.19 μmol; see Example 24, Step 1) and ethyl 2-(2-piperazin-1-ylethoxy)acetate (218.79 mg, 662.39 μmol, TFA salt) in DMF (2 mL) were added K₂CO₃ (228.87 mg, 1.66 mmol) and NaI (49.64 mg, 331.19 μmol). The mixture was stirred at 50° C. for 16 hours, diluted with H₂O (30 mL) and extracted with EtOAc (240 mL). The combined organic layers were washed with brine (70 mL), dried over Na₂SO₄, and concentrated under reduced pressure to give a residue. The residue was purified by flash chromatography (silica gel, gradient elution from 0 to 30% MeOH in DCM) to afford ethyl 2-(2-(4-(2-(2-(((5r,8r)-4-(benzyloxy)-3-mesityl-2-oxo-1-oxaspiro[4.5]dec-3-en-8-yl)oxy)ethoxy)ethyl)piperazin-1-yl)ethoxy)acetate. LCMS: RT=0.872 min, m/z 678.9 [M+H]⁺.

### B. Step 2

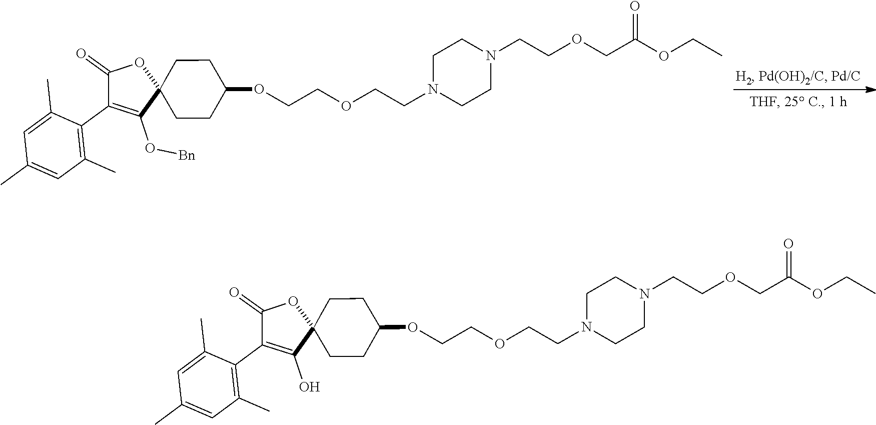

To a solution of ethyl 2-(2-(4-(2-(2-(((5r,8r)-4-(benzyloxy)-3-mesityl-2-oxo-1-oxaspiro[4.5]dec-3-en-8-yl)oxy)ethoxy)ethyl)piperazin-1-yl)ethoxy)acetate (82 mg, 120.79 μmol) in THF (2 mL) was added 10% Pd/C (10 mg) and 20% Pd(OH)₂/C (10 mg) under N₂. The mixture was degassed, purged with H₂ (3×), and stirred under 15 psi H₂ (balloon) at 25° C. for 1 hour. The mixture was filtered and the filtrate concentrated under reduced pressure to give ethyl 2-(2-(4-(2-(2-(((5r,8r)-4-hydroxy-3-mesityl-2-oxo-1-oxaspiro[4.5]dec-3-en-8-yl)oxy)ethoxy)ethyl)piperazin-1-yl)ethoxy)acetate (50 mg, crude) as a brown gum, which was used in the next step without purification. LCMS: RT=0.789 min, m/z 588.7 [M+H]f.

### C. Step 3

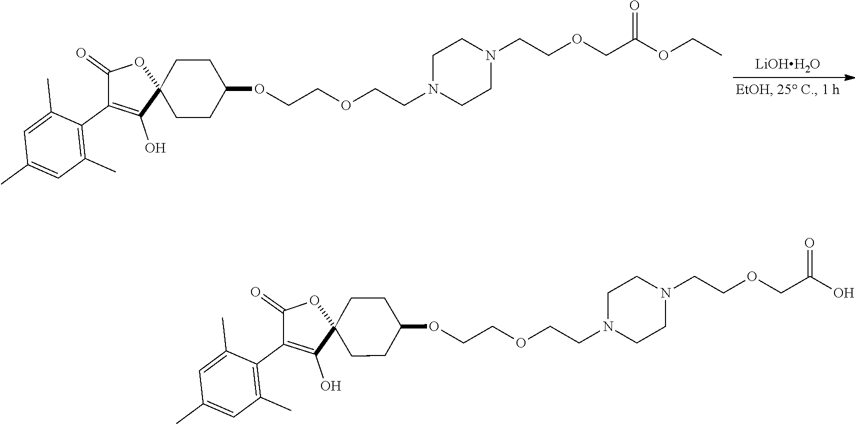

To a solution of ethyl 2-(2-(4-(2-(2-(((5r,8r)-4-hydroxy-3-mesityl-2-oxo-1-oxaspiro[4.5]dec-3-en-8-yl)oxy)ethoxy)ethyl)piperazin-1-yl)ethoxy)acetate (50 mg, 84.93 μmol, crude) in EtOH (1 mL) and H₂O (0.2 mL) was added LiOH H₂O (17.82 mg, 424.64 μmol). The mixture was stirred at 25° C. for 1 hour. The mixture was concentrated under reduced pressure to remove EtOH. The pH of the reaction mixture was adjusted to 3-4 by addition of 2 M aqueous HCl. The mixture was concentrated under reduced pressure to give 2-(2-(4-(2-(2-(((5r,8r)-4-hydroxy-3-mesityl-2-oxo-1-oxaspiro[4.5]dec-3-en-8-yl)oxy)ethoxy)-ethyl)piperazin-1-yl)ethoxy)acetic acid (91 mg, crude) as a yellow gum, which was used in the next step without further purification. LCMS: RT=0.774 min, m/z 560.7 [M+H]⁺.

### D. Step 4

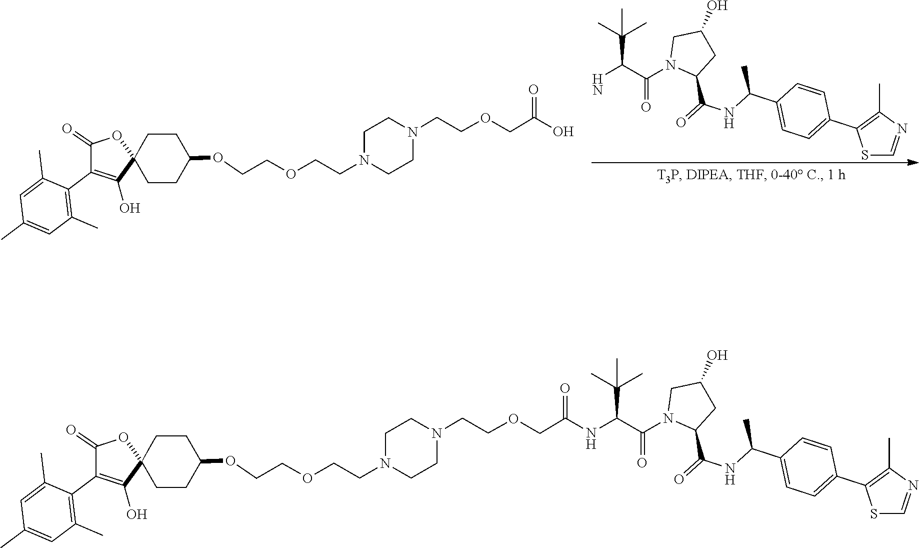

To a solution of 2-(2-(4-(2-(2-(((5r,8r)-4-hydroxy-3-mesityl-2-oxo-1-oxaspiro[4.5]dec-3-en-8-yl)oxy)ethoxy)ethyl)piperazin-1-yl)ethoxy)acetic acid (81 mg, 120.05 μmol, crude) and (2S,4R)-1-[(2S)-2-amino-3,3-dimethyl-butanoyl]-4-hydroxy-N-[(1 S)-1-[4-(4-methylthiazol-5-yl)phenyl]ethyl]pyrrolidine-2-carboxamide (64.05 mg, 133.14 μmol, HCl salt) in THF (1 mL) at 0° C. were added 50% T₃P (114.60 mg, 180.08 μmol, 107.10 μL, 50%) and DIPEA (93.09 mg, 720.32 μmol, 125.46 μL). The mixture was stirred at 40° C. for 1 hour, diluted with H₂O (20 mL) and extracted with DCM (70 mL). The combined organic layers were washed with brine (40 mL), dried over Na₂SO₄, and concentrated under reduced pressure to give a residue. The residue was purified by prep-HPLC twice (column: Unisil 3-100 C18, Ultra 150×50 mm×3 μm, mobile phase: [water (0.225% FA)-ACN], B %: 25-45, 10 min; column: Waters Xbridge 150×25 mm×5 m, mobile phase: [water (10 mM NH₄HCO₃)-ACN], B %: 18-48, 10 min) to give (2S,4R)-4-hydroxy-1-((S)-2-(2-(2-(4-(2-(2-(((5r,8r)-4-hydroxy-3-mesityl-2-oxo-1-oxaspiro[4.5]dec-3-en-8-yl)oxy)ethoxy)ethyl)-piperazin-1-yl)ethoxy)acetamido)-3,3-dimethylbutanoyl)-N—((S)-1-(4-(4-methylthiazol-5-yl)phenyl)-ethyl)pyrrolidine-2-carboxamide (7.75 mg, 7.84 μmol, 6.53% yield, 99.9% purity) as a white solid. HNMR: CDCl₃, 400 MHz. δ 8.59 (s, 1H), 7.51-7.46 (m, 1H), 7.41-7.33 (m, 4H), 7.24-7.20 (m, 1H), 6.86-6.81 (m, 2H), 5.11-5.02 (m, 1H), 4.67 (t, J=8.0 Hz, 1H), 4.56 (d, J=9.2 Hz, 1H), 4.42-4.37 (m, 1H), 3.97-3.91 (m, 3H), 3.87-3.80 (m, 2H), 3.76-3.69 (m, 3H), 3.65-3.52 (m, 7H), 2.95-2.84 (m, 3H), 2.83-2.78 (m, 2H), 2.76-2.56 (m, 5H), 2.51 (s, 3H), 2.37-2.21 (m, 6H), 2.19-2.06 (m, 7H), 2.00-1.87 (m, 4H), 1.57-1.44 (m, 5H), 1.02 (s, 9H). LCMS: RT=2.069 min, m/z 987.3 [M+H]⁺.

### Example A-23: Synthesis of (2S,4R)-4-hydroxy-1-((S)-2-(2-(2-(2-(4-(2-(2-(((5s,8s)-4-hydroxy-3-mesityl-2-oxo-1-oxaspiro[4.5]dec-3-en-8-yl)oxy)ethoxy)ethyl)piperazin-1-yl)ethoxy)ethoxy)acetamido)-3,3-dimethylbutanoyl)-N—((S)-1-(4-(4-methylthiazol-5-yl)phenyl)ethyl)pyrrolidine-2-carboxamide

### A. Step 1

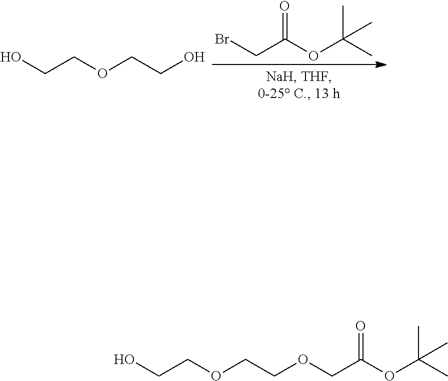

To a mixture of 2-(2-hydroxyethoxy)ethanol (21.76 g, 205.07 mmol, 19.43 mL) in THF (300 mL) was added 60% NaH (4.51 g, 112.79 mmol) at 0° C. under N₂. After 1 hour at 0° C. the mixture was treated with tert-butyl 2-bromoacetate (20 g, 102.54 mmol, 15.15 mL) and stirred at 25° C. for 12 hours. The mixture was poured into water (200 mL) and extracted with EtOAc (200 mL×3). The combined organic phases were washed with brine (200 mL), dried over anhydrous Na₂SO₄, filtered, and concentrated in vacuo. The residue was purified by column chromatography (silica gel, gradient elution from 10 to 50% EtOAc in petroleum ether) to give tert-butyl 2-[2-(2-hydroxyethoxy)ethoxy]acetate (2.2 g, 9.99 mmol, 9.74% yield) as a colorless oil. HNMR: CDCl₃, 400 MHz. δ 4.03-3.98 (m, 2H), 3.76-3.72 (m, 2H), 3.71 (s, 4H), 3.64-3.60 (m, 2H), 1.48 (s, 9H).

### B. Step 2

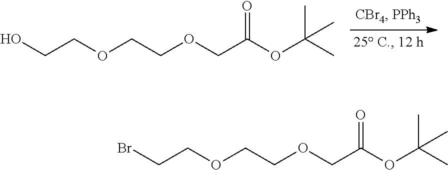

To a mixture of tert-butyl 2-[2-(2-hydroxyethoxy)ethoxy]acetate (3 g, 13.62 mmol) in DCM (50 mL) was added carbon tetrabromide (9.03 g, 27.24 mmol), followed by PPh₃ (7.14 g, 27.24 mmol). The mixture was stirred at 25° C. for 12 hours and then concentrated under reduced pressure to give a residue. The residue was purified by column chromatography (silica gel, gradient elution from 0 to 5% EtOAc in petroleum ether) to give tert-butyl 2-[2-(2-bromoethoxy)ethoxy]acetate (0.86 g, 3.04 mmol, 22.30% yield) as a yellow oil. HNMR: CDCl₃, 400 MHz. δ 4.05-4.00 (m, 2H), 3.83 (t, J=6.4 Hz, 2H), 3.74-3.68 (m, 4H), 3.49 (t, J=6.4 Hz, 2H), 1.48 (s, 9H).

### C. Step 3

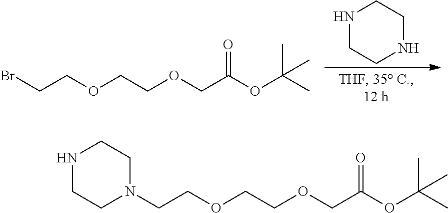

To a mixture of tert-butyl 2-[2-(2-bromoethoxy)ethoxy]acetate (650 mg, 2.30 mmol) in THF (5 mL) was added piperazine (1.98 g, 22.96 mmol). The mixture was stirred at 35° C. for 12 hours and then evaporated under reduced pressure. The residue was purified by flash chromatography (silica gel, gradient elution from 0 to 20% DCM in MeOH) to afford tert-butyl 2-[2-(2-piperazin-1-ylethoxy)ethoxy]acetate (520 mg, 1.80 mmol, 78.55% yield) as a colorless oil. HNMR: CDCl₃, 400 MHz. δ 4.02-4.00 (m, 2H), 3.71-3.68 (m, 2H), 3.65-3.60 (m, 4H), 2.95-2.86 (m, 4H), 2.58 (t, J=5.8 Hz, 4H), 2.50 (br s, 2H), 1.46 (s, 9H).

### D. Step 4

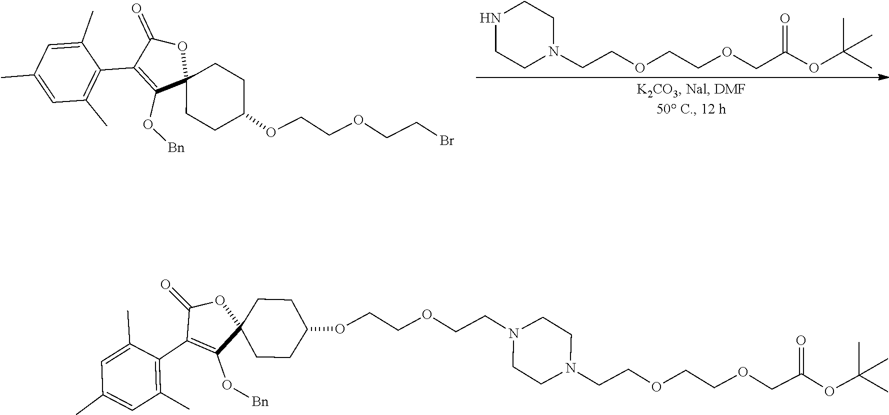 [SMILES: Cc1cc(C)c(C2=C(OCc3ccccc3)[C@]3(CC[C@H](OCCOCCBr)CC3)OC2=O)c(C)c1 ; CC(C)(C)OC(=O)COCCOCCN1CCNCC1 ; Cc1cc(C)c(C2=C(OCc3ccccc3)[C@]3(CC[C@H](OCCOCCN4CCN(CCOCCOCC(=O)OC(C)(C)C)CC4)CC3)OC2=O)c(C)c1]

A mixture of (5s,8s)-4-(benzyloxy)-8-(2-(2-bromoethoxy)ethoxy)-3-mesityl-1-oxaspiro[4.5]dec-3-en-2-one (200.00 mg, 367.99 μmol; prepared from (5s,8s)-4-(benzyloxy)-8-hydroxy-3-mesityl-1-oxaspiro[4.5]dec-3-en-2-one using general methods described herein for the preparation of (5r,8r)-4-(benzyloxy)-8-(2-(2-bromoethoxy)ethoxy)-3-mesityl-1-oxaspiro[4.5]dec-3-en-2-one), tert-butyl 2-[2-(2-piperazin-1-ylethoxy)ethoxy]acetate (159.18 mg, 551.99 μmol), K₂CO₃ (152.58 mg, 1.10 mmol) and NaI (55.16 mg, 367.99 μmol) in DMF (2 mL) was stirred under N₂ at 50° C. for 12 hours. The mixture was diluted with H₂O (30 mL) and extracted with EtOAc (60 mL). The combined organic layers were washed with brine (40 mL), dried over anhydrous Na₂SO₄, filtered, and concentrated under reduced pressure to give a residue. The residue was purified by column chromatography (silica gel, gradient elution from DCM to 10% MeOH in DCM) to give tert-butyl 2-(2-(2-(4-(2-(2-(((5s,8s)-4-(benzyloxy)-3-mesityl-2-oxo-1-oxaspiro[4.5]dec-3-en-8-yl)oxy)ethoxy)ethyl)piperazin-1-yl)ethoxy)ethoxy)acetate (200 mg, 261.27 μmol, 71.00% yield, 98.1% purity) as an off-white oil. LCMS: RT=0.817 min, m/z 751.2 [M+H]⁺.

### E. Step 5

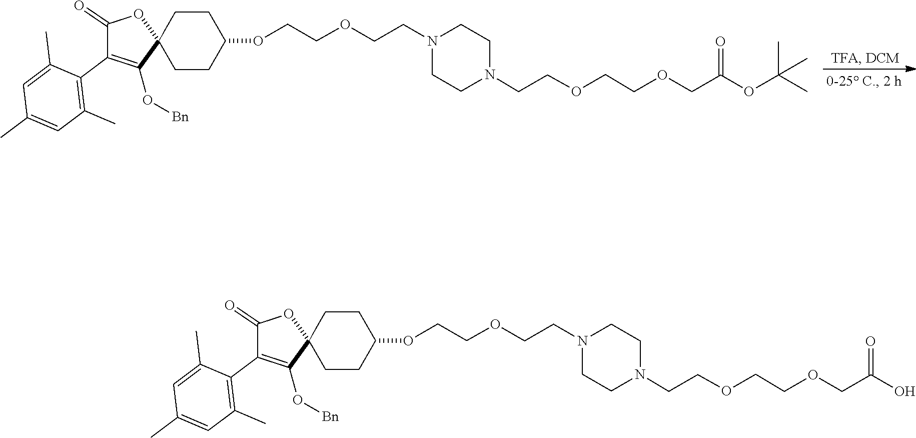

To a solution of tert-butyl 2-(2-(2-(4-(2-(2-(((5s,8s)-4-(benzyloxy)-3-mesityl-2-oxo-1-oxaspiro[4.5]dec-3-en-8-yl)oxy)ethoxy)ethyl)piperazin-1-yl)ethoxy)ethoxy)acetate (200 mg, 266.33 μmol) in DCM (2 mL) at 0° C. was added TFA (1.54 g, 13.51 mmol, 1 mL). The mixture was stirred at 25° C. for 2 hours and evaporated to dryness give 2-(2-(2-(4-(2-(2-(((5s,8s)-4-(benzyloxy)-3-mesityl-2-oxo-1-oxaspiro[4.5]dec-3-en-8-yl)oxy)ethoxy)ethyl)piperazin-1-yl)ethoxy)ethoxy)acetic acid (330 mg, crude, TFA salt) as a lightyellow oil, which was used in the next step without further purification. LCMS: RT=0.873 min, m/z 659.6 [M+H]⁺.

### F. Step 6

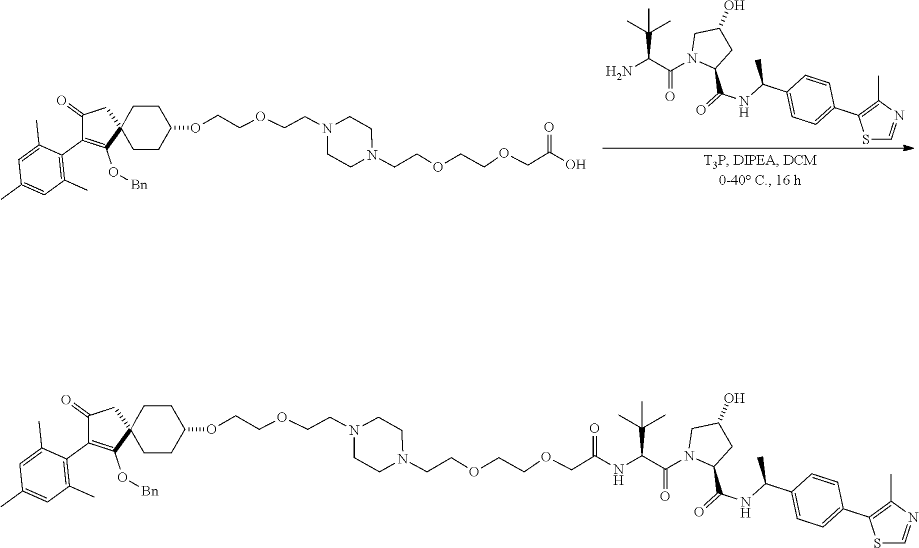

To a solution 2-(2-(2-(4-(2-(2-(((5s,8s)-4-(benzyloxy)-3-mesityl-2-oxo-1-oxaspiro[4.5]dec-3-en-8-yl)oxy)ethoxy)ethyl)piperazin-1-yl)ethoxy)ethoxy)acetic acid (330 mg, 474.92 μmol) and (2S,4R)-1-[(2S)-2-amino-3,3-dimethyl-butan oyl]-4-hydroxy-N-[(1S)-1-[4-(4-methylthiazol-5-yl)phenyl]ethyl]pyrrolidine-2-carboxamide (316.72 mg, 712.38 μmol) in DCM (5 mL) at 0° C. were added 50% T₃P (453.33 mg, 712.38 μmol, 423.67 μL) and DIPEA (368.27 mg, 2.85 mmol, 496.32 μL). The mixture was stirred at 40° C. for 16 hours, diluted with H₂O (30 mL) and extracted with DCM (40 mL). The combined organic layers were washed with brine (30 mL), dried over Na₂SO₄, filtered, and concentrated under reduced pressure to give a residue. The crude residue was purified by prep-HPLC (column: Phenomenex Synergi C18, 150×25 mm×10 μm, mobile phase: [water(0.225% FA)-ACN], B %: 26-56, 10 min) to give (2S,4R)-1-((S)-2-(2-(2-(2-(4-(2-(2-(((5s,8s)-4-(benzyloxy)-3-mesityl-2-oxo-1-oxaspiro[4.5]dec-3-en-8-yl)oxy)ethoxy)ethyl)piperazin-1-yl)ethoxy)ethoxy)acetamido)-3,3-dimethylbutanoyl)-4-hydroxy-N—((S)-1-(4-(4-methylthiazol-5-yl)phenyl)-ethyl)pyrrolidine-2-carboxamide (200 mg, 177.10 μmol, 37.29% yield, 99.3% purity) as a light-yellow gum. LCMS: RT=0.935 min, m/z 1121.8 [M+H]⁺.

### G. Step 7

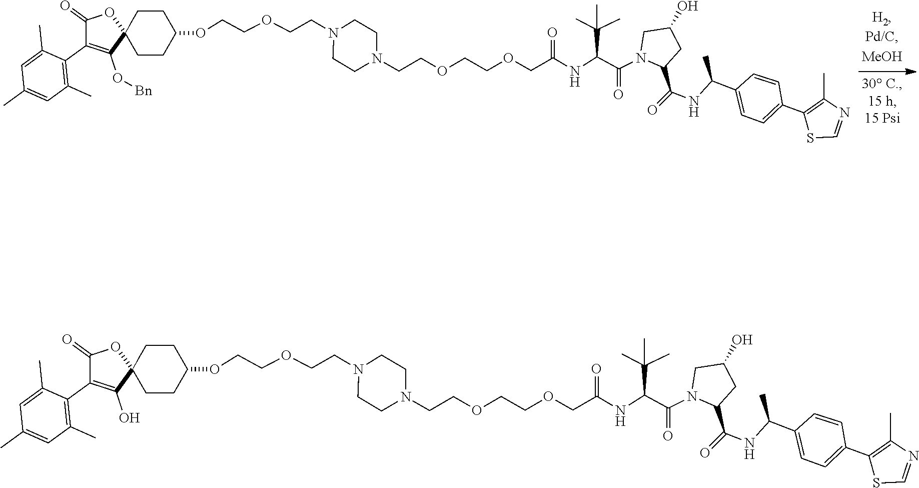

To a solution of (2S,4R)-1-((S)-2-(2-(2-(2-(4-(2-(2-(((5s,8s)-4-(benzyloxy)-3-mesityl-2-oxo-1-oxaspiro[4.5]dec-3-en-8-yl)oxy)ethoxy)ethyl)piperazin-1-yl)ethoxy)ethoxy)acetamido)-3,3-dimethylbutanoyl)-4-hydroxy-N—((S)-1-(4-(4-methylthiazol-5-yl)phenyl)ethyl)pyrrolidine-2-carboxamide (180 mg, 160.51 μmol) in MeOH (5 mL) was added 10% Pd/C (20 mg) under N₂. The mixture was degassed, purged with H₂ (3×), and stirred at 30° C. under 15 psi H₂ (balloon) for 15 hours. The mixture was filtered and the filtrate was purified by prep-HPLC (column: Phenomenex luna C18, 150×25 mm×10 μm, mobile phase: [water(0.225% FA)-ACN], B %: 24-54, 10 min) to give (2S,4R)-4-hydroxy-1-((S)-2-(2-(2-(2-(4-(2-(2-(((5s,8s)-4-hydroxy-3-mesityl-2-oxo-1-oxaspiro[4.5]dec-3-en-8-yl)oxy)ethoxy)ethyl)piperazin-1-yl)ethoxy)ethoxy)acetamido)-3,3-dimethylbutanoyl)-N—((S)-1-(4-(4-methylthiazol-5-yl)phenyl)ethyl)-pyrrolidine-2-carboxamide (23.53 mg, 21.34 μmol, 13.29% yield, 97.7% purity) as a yellow gum. HNMR: DMSO-d₆, 400 MHz. δ 8.98 (s, 1H), 8.44 (d, J=7.6 Hz, 1H), 8.13 (s, 1H), 7.48-7.32 (m, 5H), 6.75 (s, 2H), 5.23-5.11 (m, 1H), 4.94-4.85 (m, 1H), 4.55 (d, J=9.6 Hz, 1H), 4.47-4.41 (m, 1H), 4.30-4.24 (m, 1H), 3.96 (s, 2H), 3.64-3.51 (m, 17H), 2.75-2.53 (m, 10H), 2.45 (s, 3H), 2.19 (s, 3H), 2.09-2.01 (m, 7H), 1.97-1.90 (m, 2H), 1.85-1.72 (m, 3H), 1.52-1.35 (m, 7H), 0.94 (s, 9H). LCMS: RT=2.004 min, m/z 1031.5 [M+H]⁺.

### Example A-24: Synthesis of (2S,4R)-4-hydroxy-1-((S)-2-(2-(2-(2-(4-(2-(2-(((5R,8R)-4-hydroxy-3-mesityl-2-oxo-1-oxaspiro[4.5]dec-3-en-8-yl)oxy)ethoxy)ethyl)piperazin-1-yl)ethoxy)ethoxy)acetamido)-3,3-dimethylbutanoyl)-N—((S)-1-(4-(4-methylthiazol-5-yl)phenyl)ethyl)pyrrolidine-2-carboxamide

### A. Step 1

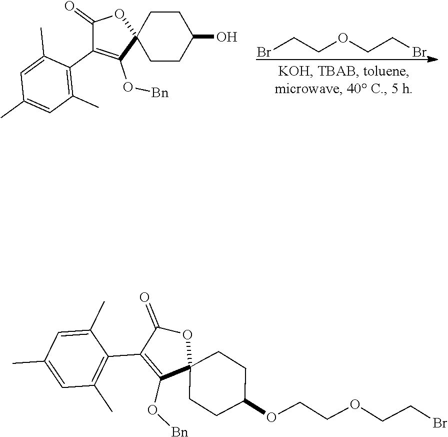

A mixture of (5r,8r)-4-(benzyloxy)-8-hydroxy-3-mesityl-1-oxaspiro[4.5]dec-3-en-2-one (650 mg, 1.66 mmol; prepared using general methods described herein for the preparation of (5s,8s)-4-(benzyloxy)-8-hydroxy-3-mesityl-1-oxaspiro[4.5]dec-3-en-2-one), 1-bromo-2-(2-bromoethoxy)ethane (1.15 g, 4.97 mmol, 622.59 μL), KOH (465 mg, 8.29 mmol) and TBAB (534 mg, 1.66 mmol) in toluene (5 mL) was stirred at 40° C. for 5 hours under microwave irradiation. The mixture was diluted with water (100 mL) and extracted with EtOAc (20 mL×2). The combined organic phases were washed with brine (100 mL), dried over Na₂SO₄, filtered, and concentrated to give a residue. The residue was purified by column chromatography (silica gel, gradient elution from 0 to 15% EtOAc in petroleum ether) to give the desired product (5r,8r)-4-(benzyloxy)-8-(2-(2-bromoethoxy)ethoxy)-3-mesityl-1-oxaspiro[4.5]dec-3-en-2-one (180 mg, 324.57 μmol, 19.60% yield, 98% purity) as a colorless oil. LCMS: RT=1.020 min, m/z 543.2 [M+H]⁺.

### B. Step 2

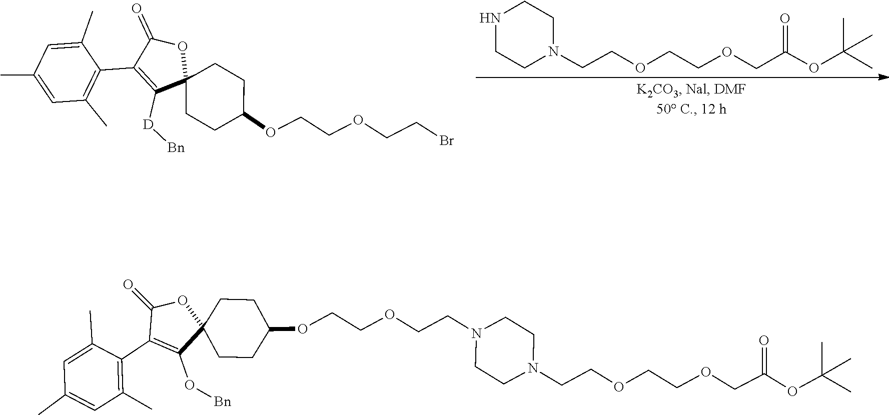

A mixture of (5r,8r)-4-(benzyloxy)-8-(2-(2-bromoethoxy)ethoxy)-3-mesityl-1-oxaspiro[4.5]dec-3-en-2-one (90 mg, 165.60 μmol), tert-butyl 2-[2-(2-piperazin-1-ylethoxy)ethoxy]acetate (287 mg, 497.60 μmol, 50% purity; see Example 23, Step 3), K₂CO₃ (92 mg, 665.65 μmol) and NaI (24 mg, 160.12 μmol) in DMF (5 mL) was stirred at 50° C. for 12 hours. The mixture was diluted with water (50 mL) and extracted with EtOAc (20 mL×2). The combined organic phases were washed with brine (30 mL×3), dried over Na₂SO₄, filtered, and concentrated to give a residue. The residue was purified by column chromatography (silica gel, gradient elution from 0 to 15% EtOAc in petroleum ether) to give tert-butyl 2-(2-(2-(4-(2-(2-(((5r,8r)-4-(benzyloxy)-3-mesityl-2-oxo-1-oxaspiro[4.5]dec-3-en-8-yl)oxy)ethoxy)ethyl)piperazin-1-yl)ethoxy)ethoxy)acetate (60 mg, 78.30 μmol, 67.55% yield, 98% purity) as a light-yellow oil. LCMS: RT=0.879 min, m/z 751.4 [M+H]⁺.

### C. Step 3

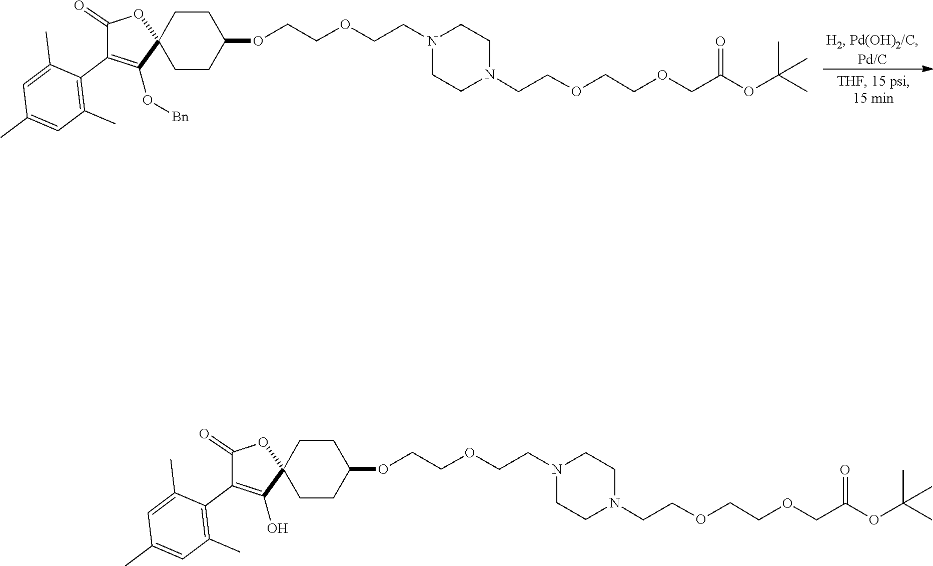

To a mixture of tert-butyl 2-(2-(2-(4-(2-(2-(((5r,8r)-4-(benzyloxy)-3-mesityl-2-oxo-1-oxaspiro[4.5]dec-3-en-8-yl)oxy)ethoxy)ethyl)piperazin-1-yl)ethoxy)ethoxy)acetate (60 mg, 79.90 μmol) in THE (5 mL) were added 20% Pd(OH)₂/C (10 mg) and 10% Pd/C (10 mg) under N₂. The mixture was degassed, purged with H₂ (3×), and stirred at 25° C. for 15 minutes under 15 psi H₂ (balloon). The mixture was filtered and the filtrate was concentrated to give tert-butyl 2-(2-(2-(4-(2-(2-(((5r,8r)-4-hydroxy-3-mesityl-2-oxo-1-oxaspiro[4.5]dec-3-en-8-yl)oxy)ethoxy)ethyl)piperazin-1-yl)ethoxy)ethoxy)acetate (52 mg, crude) as an off-white solid, which was used in the next step without further purification. LCMS: RT=0.800 min, m/z 661.4 [M+H]⁺.

### D. Step 4

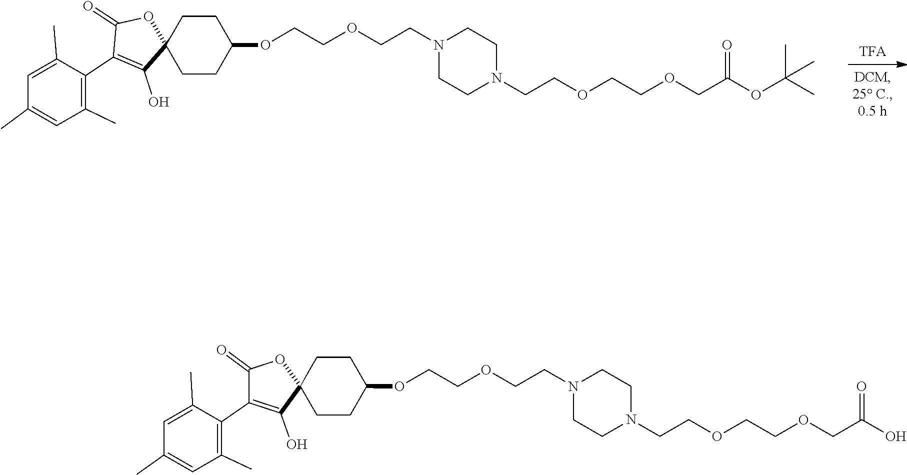

To a mixture of tert-butyl 2-(2-(2-(4-(2-(2-(((5r,8r)-4-hydroxy-3-mesityl-2-oxo-1-oxaspiro[4.5]dec-3-en-8-yl)oxy)ethoxy)ethyl)piperazin-1-yl)ethoxy)ethoxy)acetate (52 mg, 78.69 μmol) in DCM (2 mL) was added TFA (1.54 g, 13.51 mmol, 1 mL). The mixture was stirred at 25° C. for 0.5 hour and concentrated to give the desired product 2-(2-(2-(4-(2-(2-(((5r,8r)-4-hydroxy-3-mesityl-2-oxo-1-oxaspiro[4.5]dec-3-en-8-yl)oxy)ethoxy)ethyl)piperazin-1-yl)ethoxy)ethoxy)acetic acid (56 mg, crude) as a yellow oil, which was used in the next step without further purification. LCMS: RT=0.813 min, m/z 605.3 [M+H]⁺.

### E. Step 5

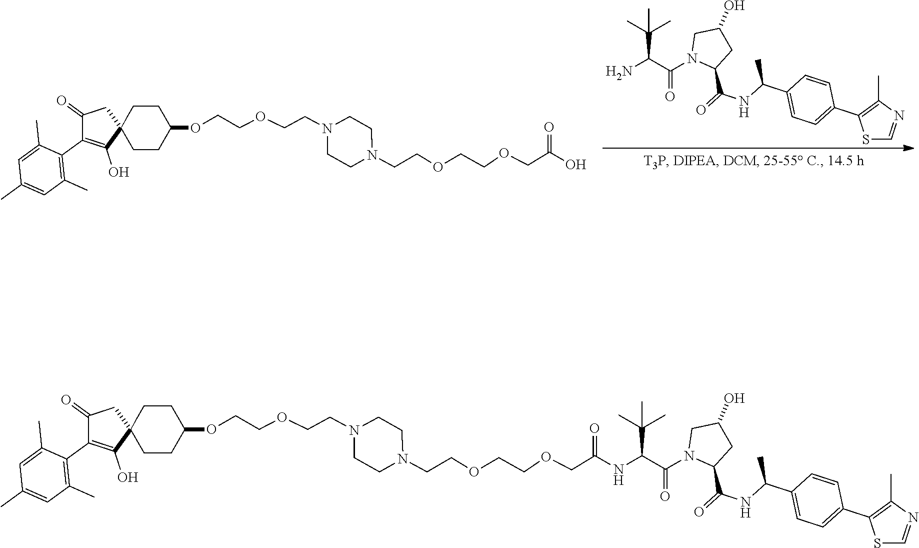

To a mixture of 2-(2-(2-(4-(2-(2-(((5r,8r)-4-hydroxy-3-mesityl-2-oxo-1-oxaspiro[4.5]dec-3-en-8-yl)oxy)ethoxy)ethyl)piperazin-1-yl)ethoxy)ethoxy)acetic acid (56 mg, 77.91 μmol) and (2S,4R)-1-[(2S)-2-amino-3,3-dimethyl-butanoyl]-4-hydroxy-N-[(1S)-1-[4-(4-methylthiazol-5-yl)phenyl]ethyl]pyrrolidine-2-carboxamide (45 mg, 93.55 μmol, HCl salt) in DCM (3 mL) were added DIPEA (50 mg, 386.87 μmol, 67.39 μL) and 50% T₃P (74.37 mg, 116.87 μmol, 69.51 μL). The mixture was stirred under nitrogen at 25° C. for 12 hours at which point LCMS showed remaining starting material. Additional DIPEA (30 mg, 232.12 μmol, 40.43 μL) and 50% T₃P (50 mg, 78.57 μmol, 46.73 μL) were added, and the mixture was stirred at 55° C. for 2.5 hours, diluted with water (50 mL) and extracted with DCM (20 mL×2). The combined organic phases were washed with brine (30 mL×3), dried over Na₂SO₄, filtered, and concentrated to give a residue. The residue was purified by prep-HPLC (column: Phenomenex Luna C18, 150×25 mm×10 μm; mobile phase: [water (0.225% FA)-ACN], B %: 20-50, 10 min) to give (2S,4R)-4-hydroxy-1-((S)-2-(2-(2-(2-(4-(2-(2-(((5r,8r)-4-hydroxy-3-mesityl-2-oxo-1-oxaspiro[4.5]dec-3-en-8-yl)oxy)ethoxy)ethyl)piperazin-1-yl)ethoxy)ethoxy)acetamido)-3,3-dimethylbutanoyl)-N—((S)-1-(4-(4-methylthiazol-5-yl)phenyl)ethyl)pyrrolidine-2-carboxamide (34.52 mg, 32.53 μmol, 41.76% yield, 97.2% purity) as a brown gum. HNMR: DMSO-d₆, 400 MHz. δ 8.99 (s, 1H), 8.44 (d, J=7.6 Hz, 1H), 8.15 (s, 1H), 7.34-7.47 (m, 5H), 6.74 (s, 2H), 4.84-4.95 (m, 1H), 4.55 (d, J=5.6 Hz, 1H), 4.40-4.48 (m, 1H), 4.21-4.30 (m, 1H), 3.96 (s, 2H), 3.48-3.67 (m, 17H), 2.71-2.83 (m, 5H), 2.53-2.65 (m, 5H), 2.46 (s, 3H), 2.19 (s, 3H), 2.00-2.11 (m, 9H), 1.82-1.92 (m, 2H), 1.62-1.80 (m, 3H), 1.36-1.49 (m, 3H), 1.20-1.28 (m, 2H), 0.95 (s, 9H). LCMS: RT=2.074 min, m/z 516.3 [M/2+H]*.

### Example A-25: Synthesis of (2S,4R)-1-((S)-2-(tert-butyl)-14-(4-(2-(2-(((5S,8S)-4-hydroxy-3-mesityl-2-oxo-1-oxaspiro[4.5]dec-3-en-8-yl)oxy)ethoxy)ethyl)piperazin-1-yl)-4-oxo-6,9,12-trioxa-3-azatetradecanoyl)-4-hydroxy-N—((S)-1-(4-(4-methylthiazol-5-yl)phenyl)ethyl)pyrrolidine-2-carboxamide

### A. Step 1

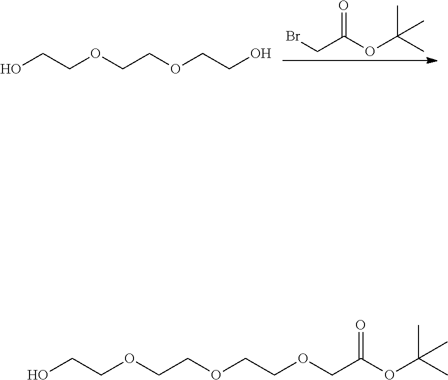

To a solution of 2-[2-(2-hydroxyethoxy)ethoxy]ethanol (15.40 g, 102.54 mmol, 13.75 mL) in THF (100 mL) was added NaH (2.26 g, 56.39 mmol, 60% purity) at 0° C. under N₂. After 0.5 hours, tert-butyl 2-bromoacetate (10 g, 51.27 mmol, 7.58 mL) was added to the mixture at 0° C. The resulting mixture was stirred at 25° C. for 12 hours under N₂. The mixture was added to water (500 mL) and extracted with EtOAc (500 mL×2). The combined organic phases were dried over anhydrous Na₂SO₄, filtered, and concentrated in vacuo. The residue was purified by column chromatography (silica gel, gradient elution from 3:1 to 1:1 petroleum ether:EtOAc) to give tert-butyl 2-[2-[2-(2-hydroxyethoxy)ethoxy]ethoxy]acetate (3 g, 11.35 mmol, 22.14% yield) as a colorless oil. HNMR: CDCl₃, 400 MHz. δ 4.01 (s, 2H), 3.74-3.68 (m, 6H), 3.68-3.65 (s, 4H), 3.62-3.58 (m, 2H), 1.46 (s, 9H).

### B. Step 2

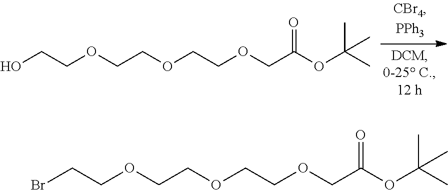 [SMILES: CC(C)(C)OC(=O)COCCOCCOCCO ; CC(C)(C)OC(=O)COCCOCCOCCBr]

To a solution of tert-butyl 2-[2-[2-(2-hydroxyethoxy)ethoxy]ethoxy]acetate (4.8 g, 18.16 mmol) and CBr₄ (6.02 g, 18.16 mmol) in DCM (80 mL) was added PPh₃ (4.76 g, 18.16 mmol) at 0° C. The mixture was stirred at 25° C. for 12 hours. The reaction mixture was concentrated under reduced pressure to give a residue. The residue was purified by column chromatography (silica gel, gradient elution from 8:1 to 5:1 petroleum ether:EtOAc) to give tert-butyl 2-[2-[2-(2-bromoethoxy)ethoxy]ethoxy]acetate (2.6 g, 7.95 mmol, 43.75% yield) as a colorless oil. HNMR: CDCl₃, 400 MHz. δ 4.03 (s, 2H), 3.81 (t, J=6.4 Hz, 2H), 3.74-3.66 (m, 8H), 3.48 (t, J=6.4 Hz, 2H), 1.48 (s, 9H).

### C. Step 3

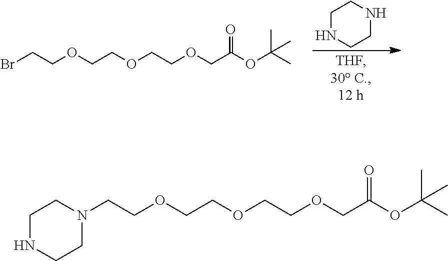 [SMILES: CC(C)(C)OC(=O)COCCOCCOCCBr ; C1CNCCN1 ; CC(C)(C)OC(=O)COCCOCCOCCN1CCNCC1]

A mixture of piperazine (2.63 g, 30.56 mmol) and tert-butyl 2-[2-[2-(2-bromoethoxy)-ethoxy]ethoxy]acetate (1 g, 3.06 mmol) in THF (20 mL) was stirred at 30° C. for 12 hours under N₂. The reaction mixture was filtered and the filtrate concentrated under reduced pressure to give a residue. The residue was purified by column chromatography (silica gel, gradient elution from 20:1 to 10:1 DCM:MeOH) to give tert-butyl 2-[2-[2-(2-piperazin-1-ylethoxy)ethoxy]ethoxy]acetate (930 mg, 2.80 mmol, 91.54% yield) as a yellow oil. HNMR: CDCl₃, 400 MHz. δ 4.02 (s, 2H), 3.73-3.60 (m, 10H), 2.92-2.85 (m, 4H), 2.58 (t, J=6.0 Hz, 2H), 2.53-2.39 (m, 4H), 1.97-1.92 (m, 2H), 1.47 (s, 9H). LCMS: RT=0.890 min, m/z 333.3 [M+H]⁺.

### D. Step 4

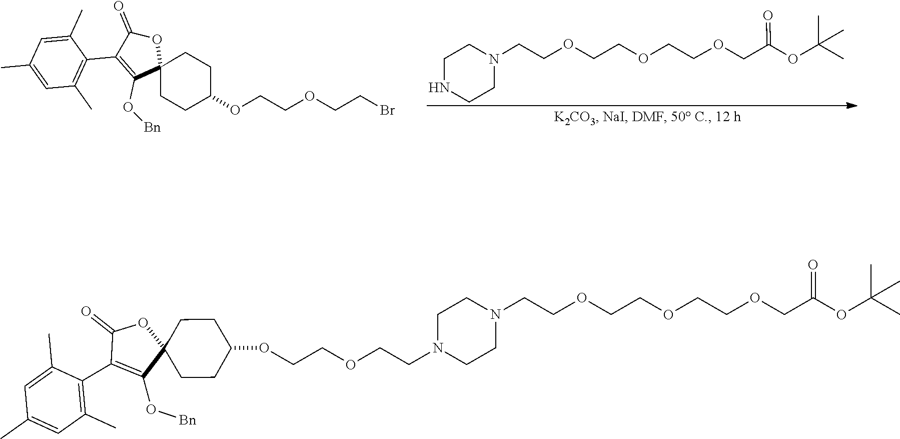 [SMILES: Cc1cc(C)c(C2=C(OCc3ccccc3)[C@]3(CC[C@H](OCCOCCBr)CC3)OC2=O)c(C)c1 ; CC(C)(C)OC(=O)COCCOCCOCCN1CCNCC1 ; Cc1cc(C)c(C2=C(OCc3ccccc3)[C@]3(CC[C@H](OCCOCCN4CCN(CCOCCOCCOCC(=O)OC(C)(C)C)CC4)CC3)OC2=O)c(C)c1]

To a stirred solution of (5s,8s)-4-(benzyloxy)-8-(2-(2-bromoethoxy)ethoxy)-3-mesityl-1-oxaspiro[4.5]dec-3-en-2-one (300 mg, 551.99 μmol; prepared from (5s,8s)-4-(benzyloxy)-8-hydroxy-3-mesityl-1-oxaspiro[4.5]dec-3-en-2-one using general methods described herein for the preparation of (5r,8r)-4-(benzyloxy)-8-(2-(2-bromoethoxy)ethoxy)-3-mesityl-1-oxaspiro[4.5]dec-3-en-2-one) and tert-butyl 2-[2-[2-(2-piperazin-1-ylethoxy)ethoxy]ethoxy]acetate (367.00 mg, 1.10 mmol) in DMF (5 mL) was added K₂CO₃ (152.58 mg, 1.10 mmol) and NaI (8.27 mg, 55.20 μmol). The mixture was stirred at 50° C. for 12 hours, diluted with H₂O (40 mL) and extracted with EtOAc (60 mL×3). The combined organic layers were dried over anhydrous Na₂SO₄, filtered, and concentrated under reduced pressure to give a residue. The residue was purified by column chromatography (silica gel, gradient elution from 50:1 to 20:1 DCM:MeOH) to give tert-butyl 2-(2-(2-(2-(4-(2-(2-(((5s,8s)-4-(benzyloxy)-3-mesityl-2-oxo-1-oxaspiro[4.5]dec-3-en-8-yl)oxy)ethoxy)ethyl)piperazin-1-yl)ethoxy)ethoxy)ethoxy)acetate (330 mg, 415.09 μmol, 75.20% yield) as yellow oil, which was used in the next step without further purification. LCMS: RT=0.816 min, m/z 795.6 [M+H]⁺.

### E. Step 5

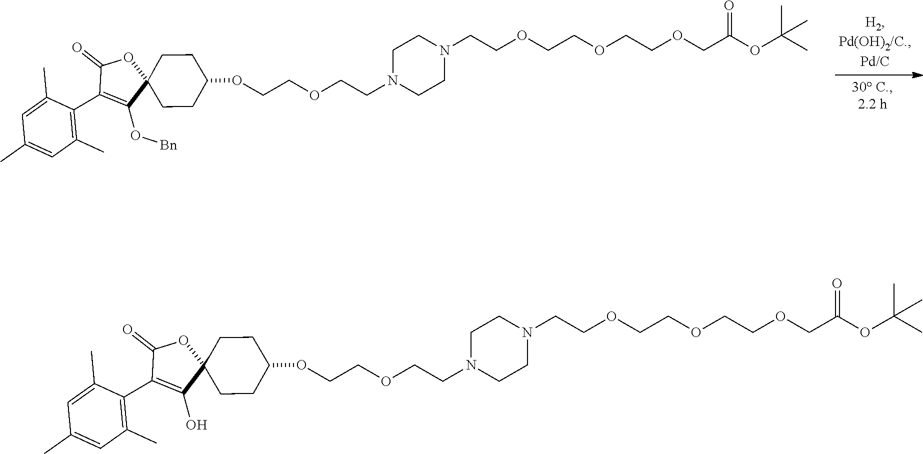

To a stirred solution of tert-butyl 2-(2-(2-(2-(4-(2-(2-(((5s,8s)-4-(benzyloxy)-3-mesityl-2-oxo-1-oxaspiro[4.5]dec-3-en-8-yl)oxy)ethoxy)ethyl)piperazin-1-yl)ethoxy)ethoxy)ethoxy)acetate (150 mg, 188.68 μmol) in THE (5 mL) was added 10% Pd/C (20 mg) and 20% Pd(OH)₂/C (20 mg) under N₂. The mixture was degassed, purged with H₂ (3×) and stirred at 30° C. under 15 psi H₂ (balloon). After 2.2 hours the mixture was filtered and the filtrate concentrated at reduced pressure to give tert-butyl 2-(2-(2-(2-(4-(2-(2-(((5s,8s)-4-hydroxy-3-mesityl-2-oxo-1-oxaspiro[4.5]dec-3-en-8-yl)oxy)ethoxy)ethyl)piperazin-1-yl)ethoxy)ethoxy)ethoxy)acetate (130 mg, crude) as a yellow oil, which was used in the next step without further purification. LCMS: RT=0.827 min, m/z 705.6 [M+H]⁺.

### F. Step 6

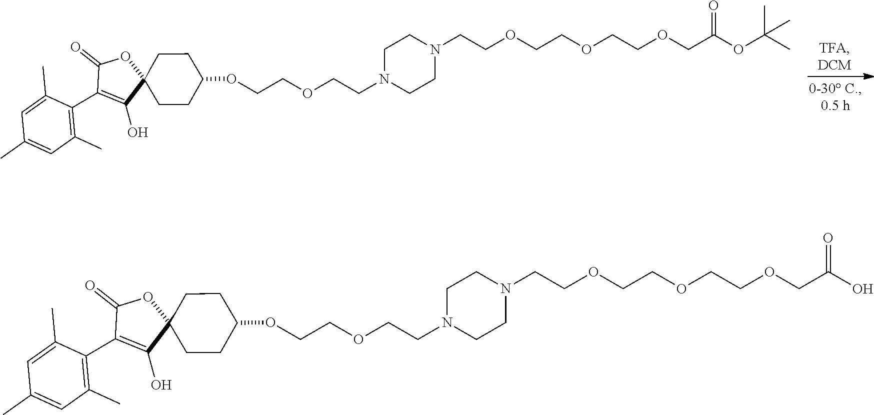

To a stirred solution of tert-butyl 2-(2-(2-(2-(4-(2-(2-(((5s,8s)-4-hydroxy-3-mesityl-2-oxo-1-oxaspiro[4.5]dec-3-en-8-yl)oxy)ethoxy)ethyl)piperazin-1-yl)ethoxy)ethoxy)ethoxy)acetate (130 mg, 184.43 μmol) in DCM (2 mL) was added TFA (1 mL) at 0° C. The mixture was stirred at 30° C. for 0.5 hours and concentrated to dryness at reduced pressure to afford 2-(2-(2-(2-(4-(2-(2-(((5s,8s)-4-hydroxy-3-mesityl-2-oxo-1-oxaspiro[4.5]dec-3-en-8-yl)oxy)ethoxy)ethyl)piperazin-1-yl)ethoxy)ethoxy)ethoxy)acetic acid (160 mg, crude, di-TFA salt) as a brown oil, which was used in the next step without further purification. LCMS: RT=0.769 min, m/z 649.5 [M+H]⁺.

### G. Step 7

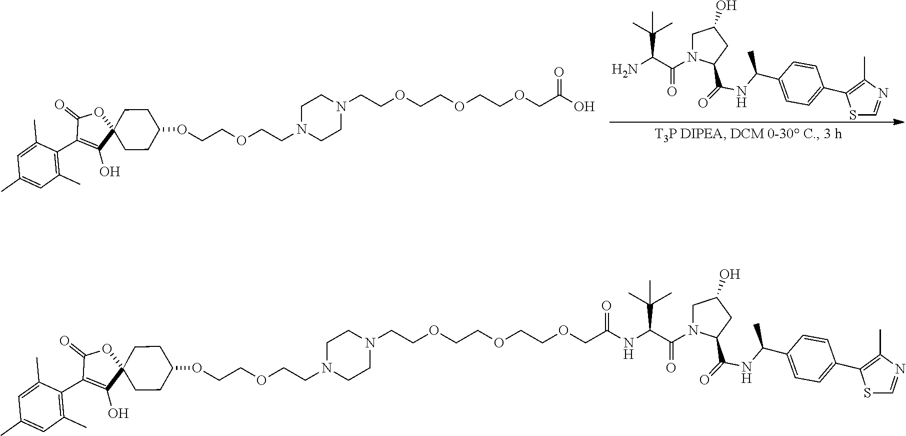 [SMILES: Cc1cc(C)c(C2=C(O)[C@]3(CC[C@H](OCCOCCN4CCN(CCOCCOCCOCC(=O)O)CC4)CC3)OC2=O)c(C)c1 ; Cc1ncsc1-c1ccc([C@H](C)NC(=O)[C@@H]2C[C@@H](O)CN2C(=O)[C@@H](N)C(C)(C)C)cc1 ; Cc1cc(C)c(C2=C(O)[C@]3(CC[C@H](OCCOCCN4CCN(CCOCCOCCOCC(=O)N[C@H](C(=O)N5C[C@H](O)C[C@H]5C(=O)N[C@@H](C)c5ccc(-c6scnc6C)cc5)C(C)(C)C)CC4)CC3)OC2=O)c(C)c1]

To a stirred mixture of 2-(2-(2-(2-(4-(2-(2-(((5s,8s)-4-hydroxy-3-mesityl-2-oxo-1-oxaspiro[4.5]dec-3-en-8-yl)oxy)ethoxy)ethyl)piperazin-1-yl)ethoxy)ethoxy)ethoxy)acetic acid (160 mg, 182.48 μmol, di-TFA salt) and (2S,4R)-1-[(2S)-2-amino-3,3-dimethyl-butanoyl]-4-hydroxy-N-[(1S)-1-[4-(4-methylthiazol-5-yl)phenyl]ethyl]pyrrolidine-2-carboxamide (131.67 mg, 273.71 μmol, HCl salt) in DCM (3 mL) were added DIPEA (141.50 mg, 1.09 mmol, 190.70 μL) and 50% T₃P (174.18 mg, 273.71 μmol, 162.79 μL) at 0° C. under N₂. The mixture was stirred at 30° C. for 3 hours. The reaction mixture was diluted with DCM (20 mL), washed with water (20 mL) and brine (20 mL×2). The organic phase was dried over anhydrous Na₂SO₄, filtered, and concentrated at reduced pressure. The residue was purified by prep-HPLC (column: Phenomenex Gemini-NX C18, 75×30 mm×3 μm, mobile phase: [water(10 mM NH₄HCO₃)-ACN]; B %: 1838, 8 min) to give (2S,4R)-1-((S)-2-(tert-butyl)-14-(4-(2-(2-(((5s,8s)-4-hydroxy-3-mesityl-2-oxo-1-oxaspiro-[4.5]dec-3-en-8-yl)oxy)ethoxy)ethyl)piperazin-1-yl)-4-oxo-6,9,12-trioxa-3-azatetradecanoyl)-4-hydroxy-N—((S)-1-(4-(4-methylthiazol-5-yl)phenyl)ethyl)pyrrolidine-2-carboxamide (47.54 mg, 42.84 μmol, 23.48% yield, 96.9% purity) as a white solid. HNMR: CDCl₃, 400 MHz. δ 8.65 (s, 1H), 7.49 (d, J=8.0 Hz, 1H), 7.41-7.29 (m, 5H), 6.82 (s, 2H), 5.12-5.03 (m, 1H), 4.69 (t, J=8.0 Hz, 1H), 4.59 (d, J=8.8 Hz, 1H), 4.44-4.38 (m, 1H), 4.09-3.94 (m, 3H), 3.72-3.52 (m, 17H), 3.40-3.33 (m, 1H), 2.79-2.47 (m, 13H), 2.42-2.34 (m, 1H), 2.28-2.19 (m, 5H), 2.16 (s, 6H), 2.09-1.90 (m, 5H), 1.82-1.69 (m, 4H), 1.47 (d, J=6.8 Hz, 3H), 1.05 (s, 9H). LCMS: RT=2.421 min, m/z 1075.6 [M+H]⁺.

### Example A-26: Synthesis of (2S,4R)-1-((S)-2-(tert-butyl)-14-(4-(2-(2-(((5R,8R)-4-hydroxy-3-mesityl-2-oxo-1-oxaspiro[4.5]dec-3-en-8-yl)oxy)ethoxy)ethyl)piperazin-1-yl)-4-oxo-6,9,12-trioxa-3-azatetradecanoyl)-4-hydroxy-N—((S)-1-(4-(4-methylthiazol-5-yl)phenyl)ethyl)pyrrolidine-2-carboxamide

### A. Step 1

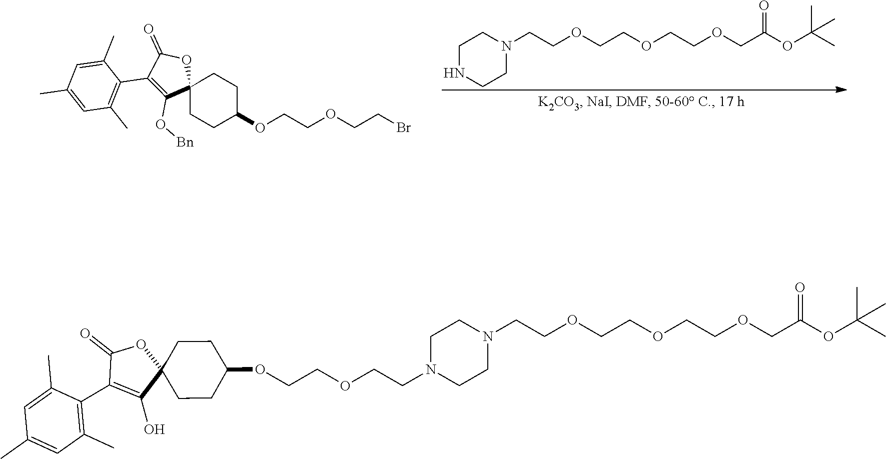 [SMILES: Cc1cc(C)c(C2=C(OCc3ccccc3)[C@]3(CC[C@@H](OCCOCCBr)CC3)OC2=O)c(C)c1 ; CC(C)(C)OC(=O)COCCOCCOCCN1CCNCC1 ; Cc1cc(C)c(C2=C(O)[C@]3(CC[C@@H](OCCOCCN4CCN(CCOCCOCCOCC(=O)OC(C)(C)C)CC4)CC3)OC2=O)c(C)c1]

To a mixture of (5r,8r)-4-(benzyloxy)-8-(2-(2-bromoethoxy)ethoxy)-3-mesityl-1-oxaspiro[4.5]dec-3-en-2-one (90 mg, 165.60 μmol; see Example 24, Step 1) and tert-butyl 2-[2-[2-(2-piperazin-1-ylethoxy)ethoxy]ethoxy]acetate (71.57 mg, 215.28 μmol) in DMF (3 mL) were added K₂CO₃ (68.66 mg, 496.79 μmol) and NaI (2.48 mg, 16.56 μmol). The mixture was stirred at 50° C. for 12 hours and at 60° C. for 5 hours. The mixture was diluted with H₂O (20 mL) and extracted with EtOAc (20 mL×3). The combined organic layers were washed with brine (20 mL×3), dried over anhydrous Na₂SO₄, filtered, and concentrated under reduced pressure to give a residue. The residue was purified by flash chromatography (silica gel, gradient elution from 0 to 4% MeOH in DCM) to give tert-butyl 2-(2-(2-(2-(4-(2-(2-(((5r,8r)-4-(benzyloxy)-3-mesityl-2-oxo-1-oxaspiro[4.5]dec-3-en-8-yl)oxy)ethoxy)ethyl)piperazin-1-yl)ethoxy)ethoxy)ethoxy)acetate (75 mg, 94.34 μmol, 56.97% yield) as a light-yellow oil. LCMS: RT=0.862 min, m/z 795.3 [M+H]⁺.

### B. Step 2

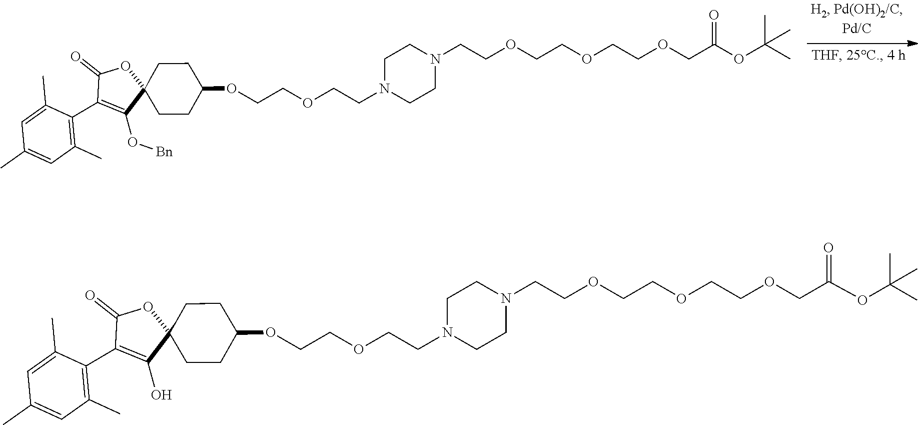

To a mixture of tert-butyl 2-(2-(2-(2-(4-(2-(2-(((5r,8r)-4-(benzyloxy)-3-mesityl-2-oxo-1-oxaspiro[4.5]dec-3-en-8-yl)oxy)ethoxy)ethyl)piperazin-1-yl)ethoxy)ethoxy)ethoxy)acetate (70 mg, 88.05 μmol) in THF (10 mL) were added 10% Pd/C (10 mg) and 20% Pd(OH)₂/C (10 mg) under N₂. The mixture was degassed, purged with H₂ (3×), and stirred at 25° C. for 4.5 hours under 15 psi H₂ (balloon). The mixture was filtered and the filtrate concentrated under reduced pressure to give tert-butyl 2-(2-(2-(2-(4-(2-(2-(((5r,8r)-4-hydroxy-3-mesityl-2-oxo-1-oxaspiro[4.5]dec-3-en-8-yl)oxy)ethoxy)ethyl)piperazin-1-yl)ethoxy)ethoxy)ethoxy)-acetate (60 mg, 85.12 μmol, 96.67% yield) as a light-yellow oil, which was used in the next step without further purification. LCMS: RT=0.651 min, n z 705.4 [M+H]⁺.

### C. Step 3

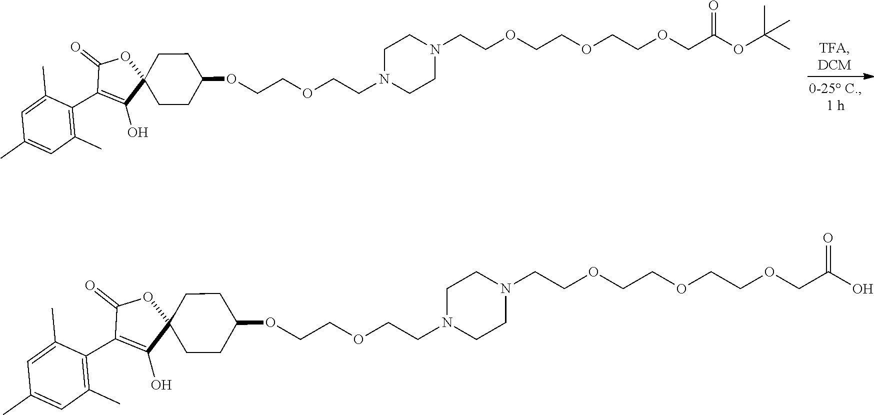

To a mixture of tert-butyl 2-(2-(2-(2-(4-(2-(2-(((5r,8r)-4-hydroxy-3-mesityl-2-oxo-1-oxaspiro[4.5]dec-3-en-8-yl)oxy)ethoxy)ethyl)piperazin-1-yl)ethoxy)ethoxy)ethoxy)acetate (60 mg, 85.12 μmol) in DCM (4 mL) at 0° C. was added TFA (3.08 g, 27.01 mmol, 2 mL). The mixture was stirred at 25° C. for 1 hour and concentrated under reduced pressure to give 2-(2-(2-(2-(4-(2-(2-(((5r,8r)-4-hydroxy-3-mesityl-2-oxo-1-oxaspiro[4.5]dec-3-en-8-yl)oxy)ethoxy)ethyl)piperazin-1-yl)ethoxy)ethoxy)ethoxy)acetic acid (60 mg, 78.66 μmol, 92.41% yield, TFA salt) as a brown oil, which was used in the next step without further purification. LCMS: RT=0.764 min, m/z 649.4 [M+H]⁺.

### D. Step 4

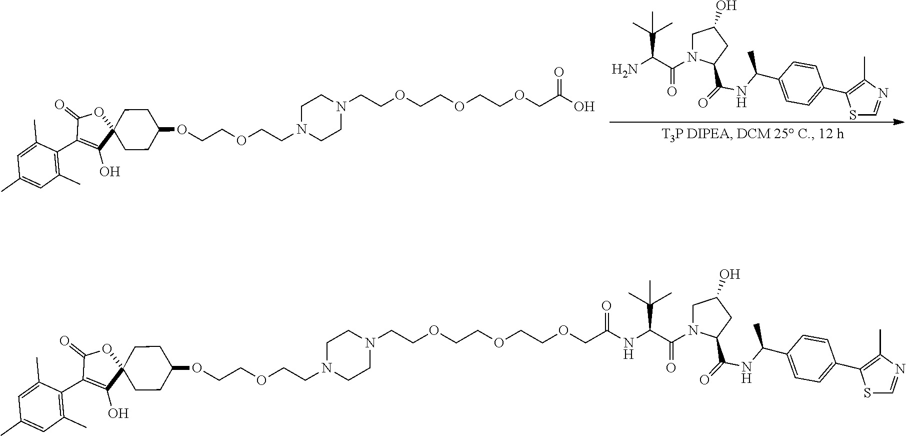 [SMILES: Cc1cc(C)c(C2=C(O)[C@]3(CC[C@@H](OCCOCCN4CCN(CCOCCOCCOCC(=O)O)CC4)CC3)OC2=O)c(C)c1 ; Cc1ncsc1-c1ccc([C@H](C)NC(=O)[C@@H]2C[C@@H](O)CN2C(=O)[C@@H](N)C(C)(C)C)cc1 ; Cc1cc(C)c(C2=C(O)[C@]3(CC[C@@H](OCCOCCN4CCN(CCOCCOCCOCC(=O)N[C@H](C(=O)N5C[C@H](O)C[C@H]5C(=O)N[C@@H](C)c5ccc(-c6scnc6C)cc5)C(C)(C)C)CC4)CC3)OC2=O)c(C)c1]

To a mixture of (2S,4R)-1-[(2S)-2-amino-3,3-dimethyl-butanoyl]-4-hydroxy-N-[(1S)-1-[4-(4-methylthiazol-5-yl)phenyl]ethyl]pyrrolidine-2-carboxamide (45.41 mg, 94.39 μmol, HCl salt) and 2-(2-(2-(2-(4-(2-(2-(((5r,8r)-4-hydroxy-3-mesityl-2-oxo-1-oxaspiro[4.5]dec-3-en-8-yl)oxy)ethoxy)ethyl)piperazin-1-yl)-ethoxy)ethoxy)ethoxy)acetic acid (60 mg, 78.66 μmol, TFA salt) in DCM (1 mL) were added 50% T₃P (75.08 mg, 117.99 μmol, 70.17 μL) and DIPEA (40.66 mg, 314.63 μmol, 54.80 μL). The mixture was stirred at 25° C. for 12 hours and then concentrated under reduced pressure to give a residue. The residue was purified by prep-HPLC twice (column: Phenomenex Synergi C18, 150×25 mm×10 μm, mobile phase: [water (0.225% FA)-ACN]; B %: 48-78, 10 min); column: Waters Xbridge, 150×25 mm×5 m; mobile phase: [water (10 mM NH₄HCO₃)-ACN]; B %: 20-50, 10 min) to give (2S,4R)-1-((S)-2-(tert-butyl)-14-(4-(2-(2-(((5r,8r)-4-hydroxy-3-mesityl-2-oxo-1-oxaspiro[4.5]dec-3-en-8-yl)oxy)ethoxy)ethyl)piperazin-1-yl)-4-oxo-6,9,12-trioxa-3-azatetradecanoyl)-4-hydroxy-N—((S)-1-(4-(4-methylthiazol-5-yl)phenyl)ethyl)pyrrolidine-2-carboxamide (36.16 mg, 33.26 μmol, 42.28% yield, 98.9% purity) as a yellow oil. HNMR: DMSO-d₆, 400 MHz. δ 8.98 (s, 1H), 8.44 (d, J=7.6 Hz, 1H), 7.50-7.31 (m, 5H), 6.81 (s, 2H), 4.95-4.86 (m, 1H), 4.55 (d, J=9.6 Hz, 1H), 4.46-4.41 (m, 1H), 4.30-4.25 (m, 1H), 3.96 (s, 2H), 3.73-3.70 (m, 2H), 3.65-3.46 (m, 19H), 2.96-2.67 (m, 10H), 2.45 (s, 3H), 2.21 (s, 3H), 2.15-2.02 (m, 9H), 1.92-1.84 (m, 2H), 1.81-1.64 (m, 3H), 1.49-1.35 (m, 3H), 1.34-1.27 (m, 2H), 0.98-0.90 (m, 9H). LCMS: RT=1.812 min, m/z 1075.7 [M+H]⁺.

### Example A-27: Synthesis of (2S,4R)-4-hydroxy-1-((S)-2-(2-(2-(2-(4-(2-(2-(2-(((5S,8S)-4-hydroxy-3-mesityl-2-oxo-1-oxaspiro[4.5]dec-3-en-8-yl)oxy)ethoxy)ethoxy)ethyl)piperazin-1-yl)ethoxy)ethoxy)acetamido)-3,3-dimethylbutanoyl)-N—((S)-1-(4-(4-methylthiazol-5-yl)phenyl)ethyl)pyrrolidine-2-carboxamide

### A. Step 1

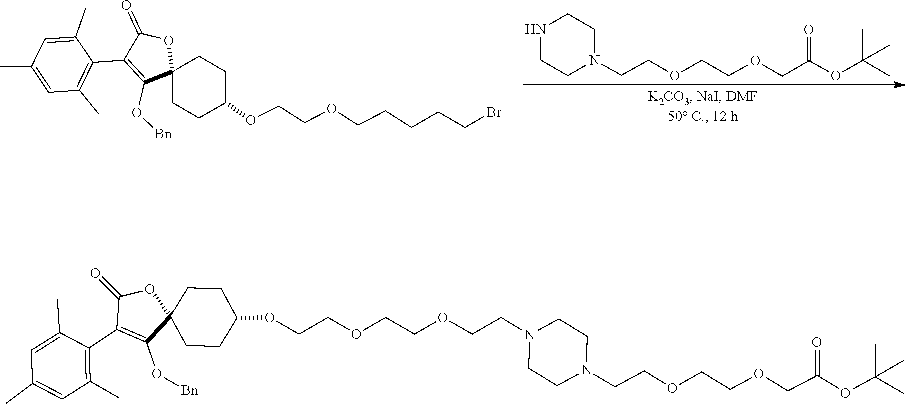 [SMILES: Cc1cc(C)c(C2=C(OCc3ccccc3)[C@]3(CC[C@H](OCCOCCCCCBr)CC3)OC2=O)c(C)c1 ; CC(C)(C)OC(=O)COCCOCCN1CCNCC1 ; Cc1cc(C)c(C2=C(OCc3ccccc3)[C@]3(CC[C@H](OCCOCCOCCN4CCN(CCOCCOCC(=O)OC(C)(C)C)CC4)CC3)OC2=O)c(C)c1]

A mixture of (5s,8s)-4-(benzyloxy)-8-(2-(2-(2-bromoethoxy)ethoxy)ethoxy)-3-mesityl-1-oxaspiro[4.5]dec-3-en-2-one (200.00 mg, 340.40 μmol; prepared from (5s,8s)-4-(benzyloxy)-8-hydroxy-3-mesityl-1-oxaspiro[4.5]dec-3-en-2-one according to Example 28, Step 3), tert-butyl 2-[2-(2-piperazin-1-ylethoxy)ethoxy]acetate (147.25 mg, 510.60 μmol; see Example 23, Step 3), K₂CO₃ (141.14 mg, 1.02 mmol) and NaI (51.02 mg, 340.40 μmol) in DMF (2 mL) was stirred under N₂ at 50° C. for 12 hours. The mixture was diluted with H₂O (30 mL) and extracted with EtOAc (60 mL). The combined organic layers were washed with brine (40 mL), dried over Na₂SO₄, filtered and concentrated under reduced pressure to give a residue. The residue was purified by column chromatography (silica gel, gradient elution from DCM to 10% MeOH in DCM) to give tert-butyl 2-(2-(2-(4-(2-(2-(2-(((5s,8s)-4-(benzyloxy)-3-mesityl-2-oxo-1-oxaspiro[4.5]dec-3-en-8-yl)oxy)ethoxy)ethoxy)ethyl)piperazin-1-yl)ethoxy)ethoxy)acetate (180 mg, 223.70 μmol, 65.71% yield, 98.8% purity) as an off-white oil. LCMS: RT=0.802 min, m/z 795.3 [M+H]⁺.

### B. Step 2

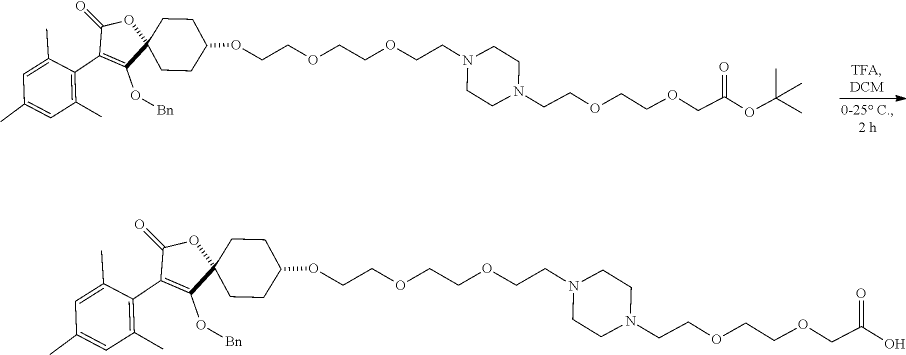

To a solution of tert-butyl 2-(2-(2-(4-(2-(2-(2-(((5s,8s)-4-(benzyloxy)-3-mesityl-2-oxo-1-oxaspiro[4.5]dec-3-en-8-yl)oxy)ethoxy)ethoxy)ethyl)piperazin-1-yl)ethoxy)ethoxy)acetate (180.00 mg, 226.41 μmol) in DCM (2 mL) at 0° C. was added TFA (1.54 g, 13.51 mmol, 1 mL). The mixture was stirred at 25° C. for 2 hours and evaporated to dryness to give 2-(2-(2-(4-(2-(2-(2-(((5s,8s)-4-(benzyloxy)-3-mesityl-2-oxo-1-oxaspiro[4.5]dec-3-en-8-yl)oxy)ethoxy)ethoxy)ethyl)piperazin-1-yl)ethoxy)ethoxy)acetic acid (250 mg, crude, TFA salt) as a light-yellow oil, which was used in the next step without further purification. LCMS: RT=0.771 min, m % z 739.2 [M+H]⁺.

### C. Step 3

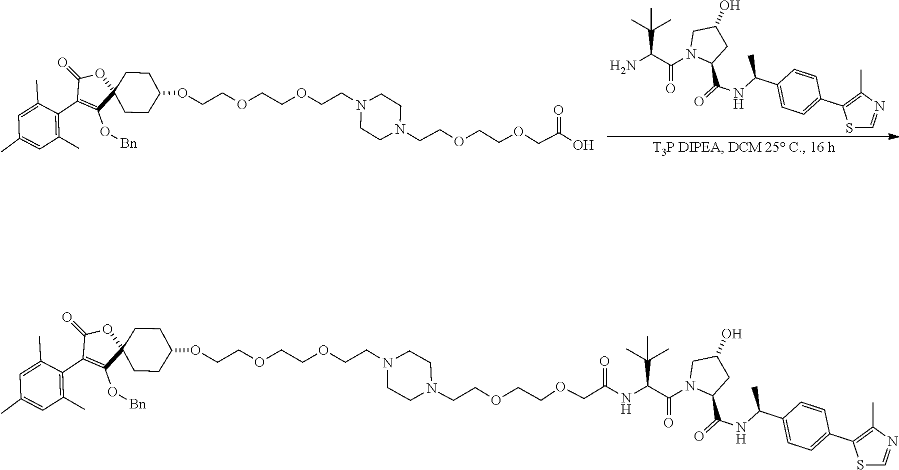 [SMILES: Cc1cc(C)c(C2=C(OCc3ccccc3)[C@]3(CC[C@H](OCCOCCOCCN4CCN(CCOCCOCC(=O)O)CC4)CC3)OC2=O)c(C)c1 ; Cc1ncsc1-c1ccc([C@H](C)NC(=O)[C@@H]2C[C@@H](O)CN2C(=O)[C@@H](N)C(C)(C)C)cc1 ; Cc1cc(C)c(C2=C(OCc3ccccc3)[C@]3(CC[C@H](OCCOCCOCCN4CCN(CCOCCOCC(=O)N[C@H](C(=O)N5C[C@H](O)C[C@H]5C(=O)N[C@@H](C)c5ccc(-c6scnc6C)cc5)C(C)(C)C)CC4)CC3)OC2=O)c(C)c1]

To a solution of 2-(2-(2-(4-(2-(2-(2-(((5s,8s)-4-(benzyloxy)-3-mesityl-2-oxo-1-oxaspiro[4.5]dec-3-en-8-yl)oxy)ethoxy)ethoxy)ethyl)piperazin-1-yl)ethoxy)ethoxy)acetic acid (250 mg, 293.11 μmol, TFA salt) and (2S,4R)-1-[(2S)-2-amino-3,3-dimethyl-butanoyl]-4-hydroxy-N-[(1S)-1-[4-(4-methylthiazol-5-yl)phenyl]ethyl]pyrrolidine-2-carboxamide (195.47 mg, 439.66 μmol) in DCM (5 mL) were added DIPEA (227.29 mg, 1.76 mmol, 306.32 μL) and 50% T₃P (279.78 mg, 439.66 μmol, 261.48 μL). The mixture was stirred at 25° C. for 16 hours. The mixture was diluted with H₂O (20 mL) and extracted with EtOAc (60 mL). The combined organic layers were washed with brine (50 mL), dried over Na₂SO₄, filtered, and concentrated under reduced pressure to give a residue. The residue was purified by column chromatography (silica gel, gradient elution from DCM to 10% MeOH in DCM) followed by prep-HPLC (column: Phenomenex Synergi C18, 150×25 mm×10 m, mobile phase: [water (0.225% FA)-ACN]; B %: 27-57, 10 min) to afford (2S,4R)-1-((S)-2-(2-(2-(2-(4-(2-(2-(2-(((5s,8s)-4-(benzyloxy)-3-mesityl-2-oxo-1-oxaspiro[4.5]dec-3-en-8-yl)oxy)ethoxy)ethoxy)ethyl)piperazin-1-yl)ethoxy)ethoxy)acetamido)-3,3-dimethylbutanoyl)-4-hydroxy-N—((S)-1-(4-(4-methylthiazol-5-yl)phenyl)ethyl)pyrrolidine-2-carboxamide (95 mg, 80.70 μmol, 27.53% yield, 99% purity) as a light-yellow gum. LCMS: RT=0.949 min, m/z 1165.9 [M+H]⁺.

### D. Step 4

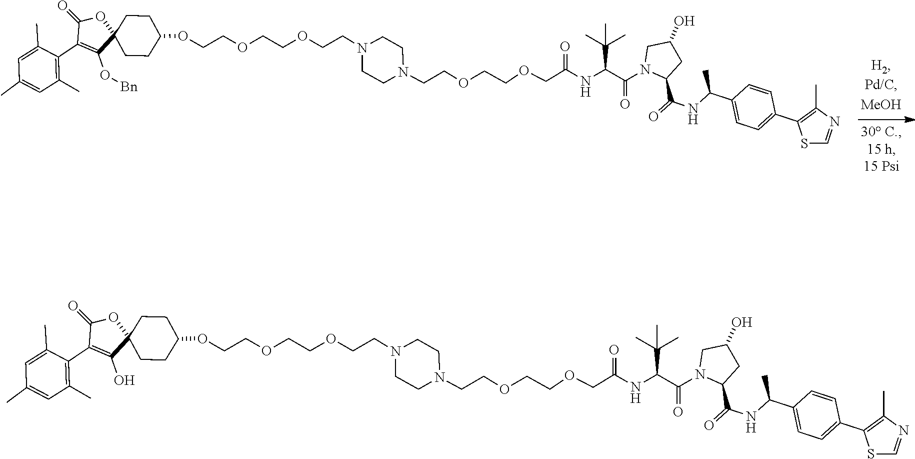 [SMILES: Cc1cc(C)c(C2=C(OCc3ccccc3)[C@]3(CC[C@H](OCCOCCOCCN4CCN(CCOCCOCC(=O)N[C@H](C(=O)N5C[C@H](O)C[C@H]5C(=O)N[C@@H](C)c5ccc(-c6scnc6C)cc5)C(C)(C)C)CC4)CC3)OC2=O)c(C)c1 ; Cc1cc(C)c(C2=C(O)[C@]3(CC[C@H](OCCOCCOCCN4CCN(CCOCCOCC(=O)N[C@H](C(=O)N5C[C@H](O)C[C@H]5C(=O)N[C@@H](C)c5ccc(-c6scnc6C)cc5)C(C)(C)C)CC4)CC3)OC2=O)c(C)c1]

To a solution of (2S,4R)-1-((S)-2-(2-(2-(2-(4-(2-(2-(2-(((5s,8s)-4-(benzyloxy)-3-mesityl-2-oxo-1-oxaspiro[4.5]dec-3-en-8-yl)oxy)ethoxy)ethoxy)ethyl)piperazin-1-yl)ethoxy)ethoxy)acetamido)-3,3-dimethylbutanoyl)-4-hydroxy-N—((S)-1-(4-(4-methylthiazol-5-yl)phenyl)ethyl)pyrrolidine-2-carboxamide (95 mg, 81.51 μmol) in MeOH (2 mL) was added 10% Pd/C (10 mg) under N₂. The mixture was degassed, purged with H₂ (3×), and stirred at 30° C. under 15 psi H₂ (balloon) for 15 hours. The mixture was filtered and the filtrate purified by prep-HPLC (column: Phenomenex Luna C18, 150×25 mm×10 μm, mobile phase: [water (0.225% FA)-ACN]; B %: 24-54, 10 min) to give (2S,4R)-4-hydroxy-1-((S)-2-(2-(2-(2-(4-(2-(2-(2-(((5s,8s)-4-hydroxy-3-mesityl-2-oxo-1-oxaspiro[4.5]dec-3-en-8-yl)oxy)ethoxy)ethoxy)ethyl)piperazin-1-yl)ethoxy)ethoxy)acetamido)-3,3-dimethylbutanoyl)-N—((S)-1-(4-(4-methylthiazol-5-yl)phenyl)ethyl)-pyrrolidine-2-carboxamide (30.80 mg, 26.72 μmol, 32.79% yield, 97.3% purity) as a yellow gum. HNMR: DMSO-d₆, 400 MHz. δ 8.98 (s, 1H), 8.44 (d, J=8.0 Hz, 1H), 8.13 (s, 1H), 7.47-7.30 (m, 5H), 6.73 (s, 2H), 5.26-5.05 (m, 1H), 4.95-4.84 (m, 1H), 4.54 (d, J=9.2 Hz, 1H), 4.47-4.40 (m, 1H), 4.30-4.23 (m, 1H), 3.98-3.91 (m, 2H), 3.62-3.52 (m, 21H), 2.70-2.56 (m, 10H), 2.45 (s, 3H), 2.18 (s, 3H), 2.09-2.01 (m, 7H), 1.97-1.89 (m, 2H), 1.84-1.72 (m, 3H), 1.52-1.41 (m, 4H), 1.37 (d, J=7.2 Hz, 3H), 0.94 (s, 9H). LCMS: RT=2.593 min, m/z 1075.5 [M+H]⁺.

### Example A-28: Synthesis of (2S,4R)-4-hydroxy-1-((S)-2-(2-(2-(2-(4-(2-(2-(2-(((5R,8R)-4-hydroxy-3-mesityl-2-oxo-1-oxaspiro[4.5]dec-3-en-8-yl)oxy)ethoxy)ethoxy)ethyl)piperazin-1-yl)ethoxy)ethoxy)acetamido)-3,3-dimethylbutanoyl)-N—((S)-1-(4-(4-methylthiazol-5-yl)phenyl)ethyl)pyrrolidine-2-carboxamide

### A. Step 1

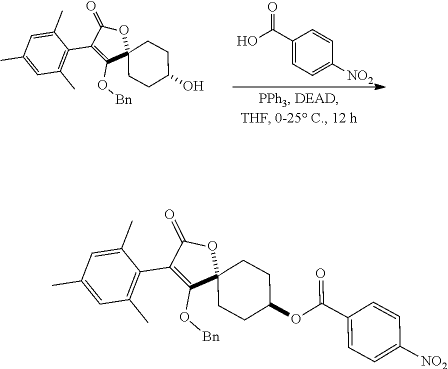 [SMILES: Cc1cc(C)c(C2=C(OCc3ccccc3)[C@]3(CC[C@H](O)CC3)OC2=O)c(C)c1 ; O=C(O)c1ccc([N+](=O)[O-])cc1 ; Cc1cc(C)c(C2=C(OCc3ccccc3)[C@]3(CC[C@@H](OC(=O)c4ccc([N+](=O)[O-])cc4)CC3)OC2=O)c(C)c1]

To a mixture of (5s,8s)-4-(benzyloxy)-8-hydroxy-3-mesityl-1-oxaspiro[4.5]dec-3-en-2-one (10 g, 25.48 mmol; see Example 7, Step 10), 4-nitrobenzoic acid (5.54 g, 33.12 mmol) and PPh₃ (10.69 g, 40.77 mmol) in THF (150 mL) was added diethyl azodicarboxylate (7.10 g, 40.77 mmol, 7.41 mL) dropwise at 0° C. The mixture was then stirred at 25° C. for 12 hours under N₂. The reaction mixture was diluted with water (200 mL), and then extracted with EtOAc (50 mL×3). The combined organic phases were washed with brine (300 mL), dried over Na₂SO₄, filtered, and concentrated under reduced pressure to give a residue. The residue was purified by column chromatography (silica gel, gradient elution from 0 to 15% EtOAc in petroleum ether) to give (5r,8r)-4-(benzyloxy)-3-mesityl-2-oxo-1-oxaspiro[4.5]dec-3-en-8-yl 4-nitrobenzoate (13.5 g, 24.93 mmol, 97.83% yield) as a white solid. HNMR: CDCl₃, 400 MHz. δ 8.13-8.23 (m, 4H), 7.38-7.44 (m, 1H), 7.31-7.37 (m, 2H), 7.06-7.11 (m, 2H), 6.93 (s, 2H), 5.48 (s, 1H), 4.82 (s, 2H), 2.36-2.46 (m, 2H), 2.32 (s, 3H), 2.12-2.26 (m, 10H), 1.71-1.80 (m, 2H).

### B. Step 2

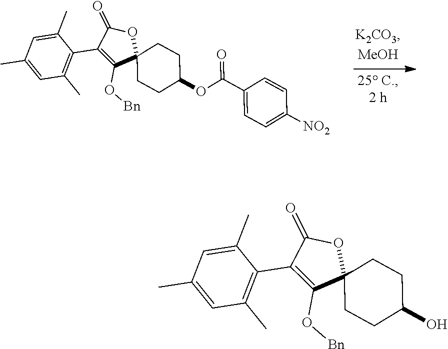 [SMILES: Cc1cc(C)c(C2=C(OCc3ccccc3)[C@]3(CC[C@@H](OC(=O)c4ccc([N+](=O)[O-])cc4)CC3)OC2=O)c(C)c1 ; Cc1cc(C)c(C2=C(OCc3ccccc3)[C@]3(CC[C@@H](O)CC3)OC2=O)c(C)c1]

A mixture of (5r,8r)-4-(benzyloxy)-3-mesityl-2-oxo-1-oxaspiro[4.5]dec-3-en-8-yl 4-nitrobenzoate (13.5 g, 24.93 mmol) and K₂CO₃ (6.89 g, 49.82 mmol) in MeOH (150 mL) was stirred at 25° C. for 2 hours and then concentrated to give a residue. The residue was diluted with water (200 mL), and then extracted with EtOAc (50 mL×2). The combined organic phases were washed with brine (200 mL), dried over Na₂SO₄, filtered, and concentrated under reduced pressure to give the crude product. The crude product was triturated with 10:1 petroleum ether:EtOAc (50 mL) to give (5r,8r)-4-(benzyloxy)-8-hydroxy-3-mesityl-1-oxaspiro[4.5]dec-3-en-2-one (9.1 g, 23.19 mmol, 93.02% yield) as a white solid. HNMR: CDCl₃, 400 MHz. δ 7.27-7.33 (m, 3H), 6.97-7.04 (m, 2H), 6.89 (s, 2H), 4.80 (s, 2H), 4.18-4.22 (m, 1H), 2.37-2.45 (m, 2H), 2.30 (s, 3H), 2.01-2.13 (m, 8H), 1.82-1.89 (m, 2H), 1.53-1.59 (m, 2H), 1.34-1.39 (m, 1H).

### C. Step 3

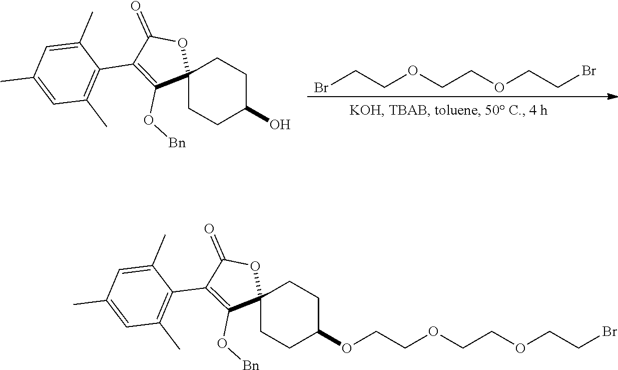

A mixture of (5r,8r)-4-(benzyloxy)-8-hydroxy-3-mesityl-1-oxaspiro[4.5]dec-3-en-2-one (500 mg, 1.27 mmol), 1,2-bis(2-bromoethoxy)ethane (879 mg, 3.19 mmol), TBAB (205 mg, 635.92 μmol) and KOH (357 mg, 6.36 mmol) in toluene (5 mL) was stirred at 50° C. for 4 hours under microwave irradiation. The mixture was diluted with water (50 mL) and extracted with EtOAc (20 mL×2). The combined organic phases were washed with brine (50 mL), dried over Na₂SO₄, filtered, and concentrated to give a residue. The residue was purified by column chromatography (silica gel, gradient elution from 0-15% EtOAc in petroleum ether) to give (5r,8r)-4-(benzyloxy)-8-(2-(2-(2-bromoethoxy)ethoxy)ethoxy)-3-mesityl-1-oxaspiro[4.5]dec-3-en-2-one (270 mg, 321.68 μmol, 12.63% yield, 70% purity) as a white solid. LCMS: RT=1.053 min, m/z 589.1 [M+H]⁺.

### D. Step 4

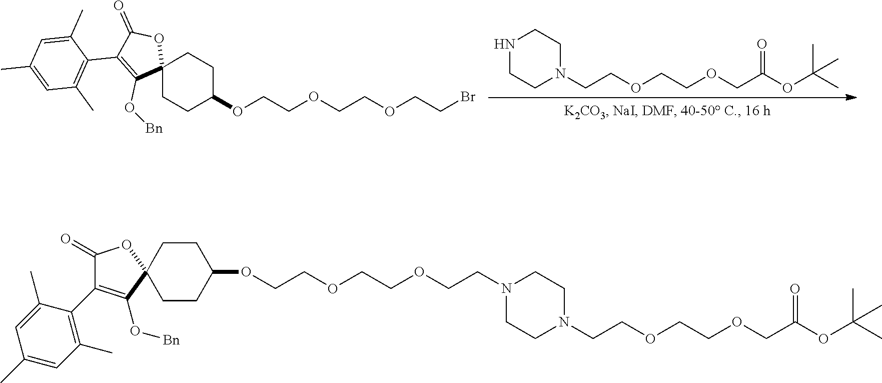

A mixture of (5r,8r)-4-(benzyloxy)-8-(2-(2-(2-bromoethoxy)ethoxy)ethoxy)-3-mesityl-1-oxaspiro[4.5]dec-3-en-2-one (270 mg, 321.68 μmol, 70% purity), tert-butyl 2-[2-(2-piperazin-1-ylethoxy)ethoxy]acetate (278 mg, 482.00 μmol, 50% purity; see Example 23, Step 3), K₂CO₃ (133 mg, 962.33 μmol) and NaI (48 mg, 320.23 μmol) in DMF (5 mL) was stirred at 40° C. for 12 hours at which point LCMS indicated unreacted starting material remaining. The reaction mixture was treated with additional portions of tert-butyl 2-[2-(2-piperazin-1-ylethoxy)ethoxy]acetate (278 mg, 482.00 μmol, 50% purity), K₂CO₃ (89 mg, 643.97 μmol) and NaI (48 mg, 320.23 μmol) and the mixture stirred at 50° C. for an additional 4 hours. The mixture was diluted with water (50 mL) and extracted with EtOAc (20 mL×2). The combined organic phases were washed with brine (50 mL×3), dried over Na₂SO₄, filtered, and concentrated to give a residue. The residue was purified by column chromatography (silica gel, gradient elution from 0 to 15% EtOAc in petroleum ether) to give tert-butyl 2-(2-(2-(4-(2-(2-(2-(((5r,8r)-4-(benzyloxy)-3-mesityl-2-oxo-1-oxaspiro[4.5]dec-3-en-8-yl)oxy)ethoxy)ethoxy)ethyl)piperazin-1-yl)ethoxy)ethoxy)acetate (180 mg, 226.41 μmol, 70.38% yield) as a colorless oil. HNMR: CDCl₃, 400 MHz. δ 7.29-7.34 (m, 3H), 6.96-7.03 (m, 2H), 6.89 (s, 2H), 4.82 (s, 2H), 4.01-4.03 (m, 2H), 3.55-3.73 (m, 16H), 2.55-3.25 (m, 10H), 2.26-2.37 (m, 5H), 2.08 (s, 6H), 1.86-2.04 (m, 4H), 1.44-1.58 (m, 14H). LCMS: RT=0.734 min, m/z 795.4 [M+H]⁺.

### E. Step 5

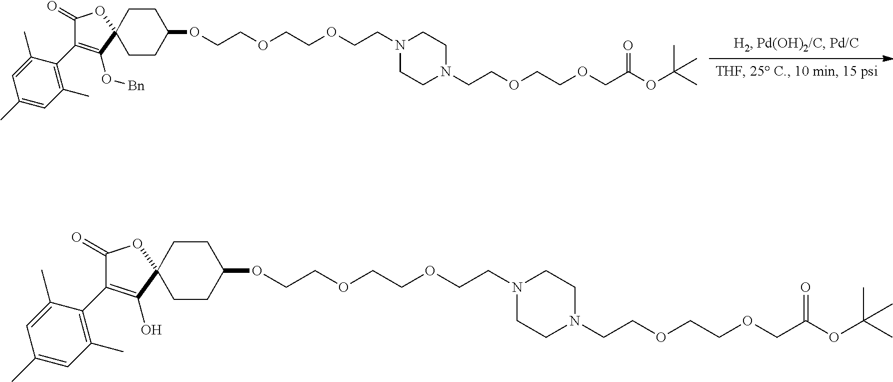

To a mixture of tert-butyl 2-(2-(2-(4-(2-(2-(2-(((5r,8r)-4-(benzyloxy)-3-mesityl-2-oxo-1-oxaspiro[4.5]dec-3-en-8-yl)oxy)ethoxy)ethoxy)ethyl)piperazin-1-yl)ethoxy)ethoxy)acetate (180 mg, 226.41 μmol) in THF (10 mL) were added 20% Pd(OH)₂/C (50 mg) and 10% Pd/C (50 mg) under N₂. The mixture was degassed, purged with H₂ (3×), and stirred at 25° C. for 10 minutes under 15 psi H₂ (balloon). The mixture was filtered and the filtrate concentrated to give tert-butyl 2-(2-(2-(4-(2-(2-(2-(((5r,8r)-4-hydroxy-3-mesityl-2-oxo-1-oxaspiro[4.5]dec-3-en-8-yl)oxy)ethoxy)ethoxy)ethyl)piperazin-1-yl)ethoxy)ethoxy)acetate (160 mg, crude) as a yellow oil, which was used in the next step without further purification. LCMS: RT=0.813 min, m/z 705.4 [M+H]⁺.

### F. Step 6

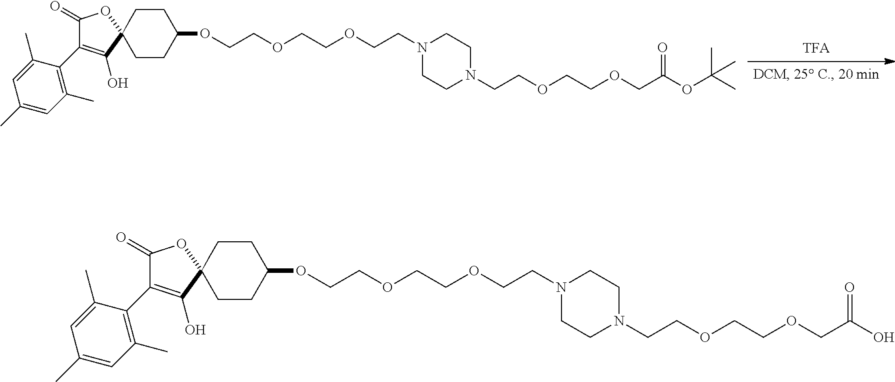

A mixture of tert-butyl 2-(2-(2-(4-(2-(2-(2-(((5r,8r)-4-hydroxy-3-mesityl-2-oxo-1-oxaspiro[4.5]dec-3-en-8-yl)oxy)ethoxy)ethoxy)ethyl)piperazin-1-yl)ethoxy)ethoxy)acetate (160 mg, 226.99 μmol) in DCM (4 mL) and TFA (3.08 g, 27.01 mmol, 2 mL) was stirred at 25° C. for 20 minutes and then concentrated to give 2-(2-(2-(4-(2-(2-(2-(((5r,8r)-4-hydroxy-3-mesityl-2-oxo-1-oxaspiro[4.5]dec-3-en-8-yl)oxy)ethoxy)ethoxy)-ethyl)piperazin-1-yl)ethoxy)ethoxy)acetic acid (170 mg, crude) as a yellow oil, which was used in the next step without further purification. LCMS: RT=0.758 min, m/z 649.3 [M+H]⁺.

### G. Step 7

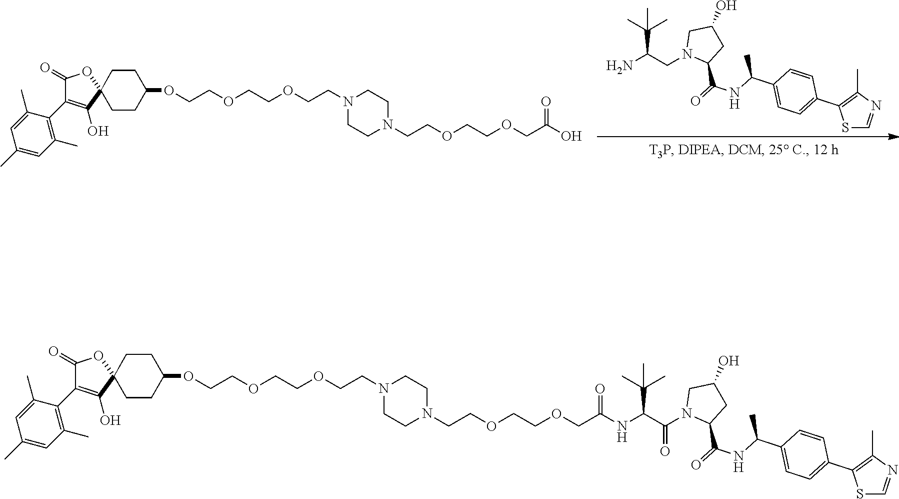

To a mixture of 2-(2-(2-(4-(2-(2-(2-(((5r,8r)-4-hydroxy-3-mesityl-2-oxo-1-oxaspiro[4.5]dec-3-en-8-yl)oxy)ethoxy)ethoxy)ethyl)piperazin-1-yl)ethoxy)ethoxy)acetic acid (170 mg, 222.86 μmol) and (2S,4R)-1-[(2S)-2-amino-3,3-dimethyl-butanoyl]-4-hydroxy-N-[(1S)-1-[4-(4-methylthiazol-5-yl)phenyl]ethyl]-pyrrolidine-2-carboxamide (129 mg, 268.16 μmol, HCl salt) in DCM (5 mL) were added DIPEA (144 mg, 1.11 mmol, 194.07 μL) and 50% T₃P (213 mg, 334.72 μmol, 199.07 μL). The mixture was then stirred at 25° C. for 12 hours under nitrogen. The mixture was diluted with water (50 mL) and extracted with DCM (20 mL×2). The combined organic phases were washed with brine (50 mL), dried over Na₂SO₄, filtered, and concentrated to give a residue. The residue was purified by prep-HPLC (column: Phenomenex Luna C18, 150×25 mm×10 μm; mobile phase: [water (0.225% FA)-ACN]; B %: 21-51, 10 min) to give (2S,4R)-4-hydroxy-1-((S)-2-(2-(2-(2-(4-(2-(2-(2-(((5r,8r)-4-hydroxy-3-mesityl-2-oxo-1-oxaspiro[4.5]dec-3-en-8-yl)oxy)ethoxy)ethoxy)ethyl)piperazin-1-yl)ethoxy)ethoxy)acetamido)-3,3-dimethylbutanoyl)-N—((S)-1-(4-(4-methylthiazol-5-yl)phenyl)ethyl)pyrrolidine-2-carboxamide (108.75 mg, 98.10 μmol, 44.02% yield, 97.0% purity) as an off-white solid. HNMR: DMSO-d₆, 400 MHz. δ 9.00 (s, 1H), 8.45 (d, J=7.6 Hz, 1H), 8.14 (s, 1H), 7.33-7.47 (m, 5H), 6.78 (s, 2H), 4.84-4.95 (m, 1H), 4.56 (d, J=9.6 Hz, 1H), 4.41-4.48 (m, 1H), 4.23-4.31 (m, 1H), 3.97 (s, 2H), 3.68-3.73 (m, 2H), 3.50-3.59 (m, 16H), 3.42-3.47 (m, 2H), 2.68-2.86 (m, 6H), 2.52-2.54 (m, 1H), 2.46 (s, 3H), 2.33-2.45 (m, 4H), 2.20 (s, 3H), 2.01-2.15 (m, 9H), 1.83-1.92 (m, 2H), 1.62-1.80 (m, 3H), 1.36-1.49 (m, 3H), 1.20-1.28 (m, 2H), 0.95 (s, 9H). LCMS: RT=2.487 min, m/z 1075.5 [M+H]⁺.

### Example A-29: Synthesis of 3-ethoxy-2-[5-(4-hydroxyphenyl)-2-methyl-phenyl]-5,5-dimethyl-cyclohex-2-en-1-one (Intermediate (Int.) 1)

### A. Step 1

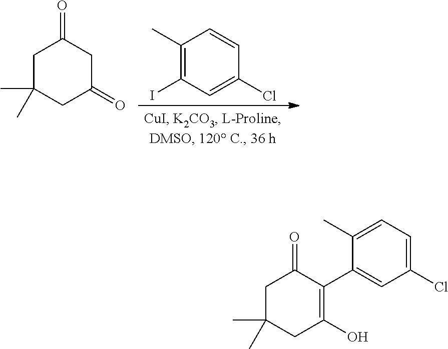

To a solution of 5,5-dimethylcyclohexane-1,3-dione (2 g, 14.27 mmol) in DMSO (40 mL) were added 4-chloro-2-iodo-1-methyl-benzene (5.40 g, 21.40 mmol), CuI (271.72 mg, 1.43 mmol), K₂CO₃ (5.92 g, 42.80 mmol) and L-Proline (328.52 mg, 2.85 mmol). The reaction mixture was degassed and purged with N₂ three times, and stirred at 120° C. for 36 hours under N₂ atmosphere. The mixture was quenched with water (50 mL) and the pH was adjusted to pH=5˜6 with concentrated HCl. The mixture was extracted with EtOAc (150 mL×3). The organic layer was washed with brine (100 mL), dried over Na₂SO₄, and concentrated to dryness. The residue was purified by column chromatography (SiO₂, PE:EtOAc=10:1 to 4:1) and triturated with MTBE (10 mL) at 25° C. for 30 minutes to afford 2-(5-chloro-2-methyl-phenyl)-3-hydroxy-5,5-dimethyl-cyclohex-2-en-1-one (1 g, 3.78 mmol, 26.47% yield) as a white solid. HNMR: CDCl₃, 400 MHz. δ 7.27-7.21 (m, 2H), 7.06-7.03 (m, 1H), 6.10 (s, 1H), 2.48-2.35 (m, 4H), 2.09 (s, 3H), 1.18 (s, 6H). LCMS: EW24526-54-PIA. RT=0.862 min, m/z 265.2 [M+H]⁺.

### B. Step 2

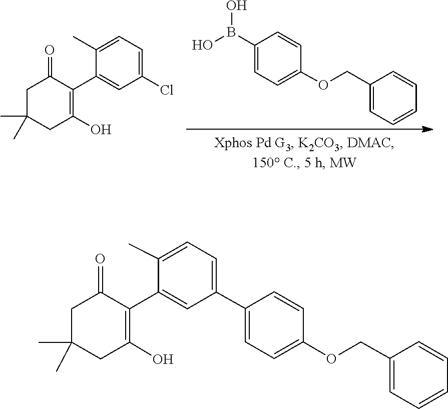 [SMILES: Cc1ccc(Cl)cc1C1=C(O)CC(C)(C)CC1=O ; OB(O)c1ccc(OCc2ccccc2)cc1 ; Cc1ccc(-c2ccc(OCc3ccccc3)cc2)cc1C1=C(O)CC(C)(C)CC1=O]

2-(5-chloro-2-methyl-phenyl)-3-hydroxy-5,5-dimethyl-cyclohex-2-en-1-one (500 mg, 1.89 mmol), (4-benzyloxyphenyl)boronic acid (1.29 g, 5.67 mmol), K₂CO₃ (783.05 mg, 5.67 mmol) and XPhos Pd G3 (159.86 mg, 188.86 μmol) were combined in a microwave tube with dimethylacetamide (10 mL). The sealed tube was purged with N₂ for several minutes and heated at 150° C. for 5 hours in a microwave reactor. The reaction mixture was partitioned between EtOAc (20 mL) and water (150 mL). The aqueous phase was extracted with EtOAc (20 mL×3). The combined extracts were washed with brine (20 mL×3), dried over Na₂SO₄, filtered, and concentrated under vacuum. The residue was purified by column chromatography (SiO₂, PE:EtOAc=50:1 to 10:1) to afford 5-(4-benzyloxyphenyl)-2-methyl-phenyl]-3-hydroxy-5,5-dimethyl-cyclohex-2-en-1-one (470 mg, 1.14 mmol) as a white solid. LCMS: RT=0.909 min, m/z 413.2 [M+H]⁺.

### C. Step 3

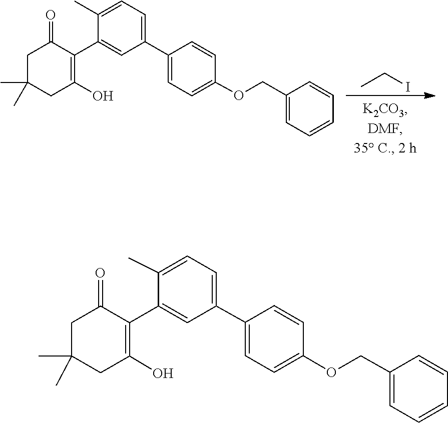

To a mixture of 2-[5-(4-benzyloxyphenyl)-2-methyl-phenyl]-3-hydroxy-5,5-dimethyl-cyclohex-2-en-1-one (470 mg, 1.14 mmol) in DMF (10 mL) was added iodoethane (266.55 mg, 1.71 mmol, 136.69 μL) and K₂CO₃ (314.93 mg, 2.28 mmol). The mixture was stirred at 35° C. for 2 hours. The reaction was partitioned between EtOAc (50 mL) and water (100 mL). The aqueous phase was extracted with EtOAc (20 mL×3). The combined extracts were washed with brine (20 mL×3), dried over Na₂SO₄, filtered, and concentrated under vacuum. The residue was purified by column chromatography (SiO₂, PE:EtOAc=10:1 to 5:1) to afford 2-[5-(4-benzyloxyphenyl)-2-methyl-phenyl]-3-ethoxy-5,5-dimethyl-cyclohex-2-en-1-one (500 mg, 1.13 mmol, 99.61% yield) as a white solid. LCMS: RT=1.084 min, m/z 441.4 [M+H]⁺.

### D. Step 4

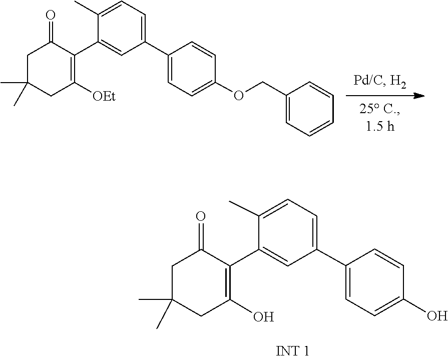 [SMILES: CCOC1=C(c2cc(-c3ccc(OCc4ccccc4)cc3)ccc2C)C(=O)CC(C)(C)C1 ; Cc1ccc(-c2ccc(O)cc2)cc1C1=C(O)CC(C)(C)CC1=O]

To a mixture of 2-[5-(4-benzyloxyphenyl)-2-methyl-phenyl]-3-ethoxy-5,5-dimethyl-cyclohex-2-en-1-one (500 mg, 1.13 mmol) in MeOH (10 mL) and THF (3 mL) was added Pd/C (150 mg, 5% purity) under the N₂. The mixture was degassed and purged with H₂ three times and stirred at 25° C. for 1.5 hours under H₂ balloon (15 psi). The mixture was filtered, and the filtrate was concentrated in vacuo to afford 3-ethoxy-2-[5-(4-hydroxyphenyl)-2-methyl-phenyl]-5,5-dimethyl-cyclohex-2-en-1-one (395 mg, 1.13 mmol, 99.32% yield) as a white solid. HNMR: CDCl₃, 400 MHz. δ 7.42-7.34 (m, 3H), 7.25-7.22 (m, 1H), 7.16-7.14 (m, 1H), 6.85-6.80 (m, 2H), 3.96-3.86 (m, 2H), 2.58 (s, 2H), 2.43 (s, 2H), 2.15 (s, 3H), 1.22 (d, J=4.0 Hz, 6H), 1.17 (t, J=7.2 Hz, 3H). LCMS: RT=0.930 min, m/z 351.1 [M+H]⁺.

### Example A-30: Synthesis of 3-ethoxy-5,5-dimethyl-2-[2-methyl-5-[4-(4-piperidyloxy)phenyl]phenyl]cyclohex-2-en-1-one (Intermediate (Int.) 2)

### A. Step 1

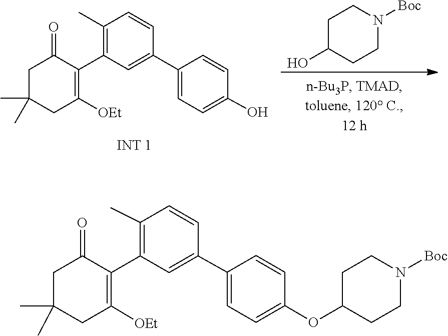 [SMILES: CCOC1=C(c2cc(-c3ccc(O)cc3)ccc2C)C(=O)CC(C)(C)C1 ; CC(C)(C)OC(=O)N1CCC(O)CC1 ; CCOC1=C(c2cc(-c3ccc(OC4CCN(C(=O)OC(C)(C)C)CC4)cc3)ccc2C)C(=O)CC(C)(C)C1]

To a mixture of 3-ethoxy-2-[5-(4-hydroxyphenyl)-2-methyl-phenyl]-5,5-dimethyl-cyclohex-2-en-1-one (INT 1) (1 g, 2.85 mmol) and tert-butyl 4-hydroxypiperidine-1-carboxylate (861.44 mg, 4.28 mmol) in toluene (10 mL) were added tributylphosphine (1.15 g, 5.71 mmol, 1.41 mL) and TMAD (982.68 mg, 5.71 mmol). The mixture was degassed and purged with N₂ three times, then stirred at 120° C. for 12 hours. The mixture was concentrated in vacuo and purified by column chromatography (SiO₂, Petroleum ether:Ethyl acetate=1:0 to 4:1) to afford tert-butyl 4-[4-[3-(2-ethoxy-4,4-dimethyl-6-oxo-cyclohexen-1-yl)-4-methyl-phenyl]phenoxy]piperidine-1-carboxylate (1.05 g, 1.97 mmol, 68.95% yield, 99.9% purity) as an off-white gum. LCMS: RT=0.987 min, m/z 534.2 [M+H]⁺

### B. Step 2

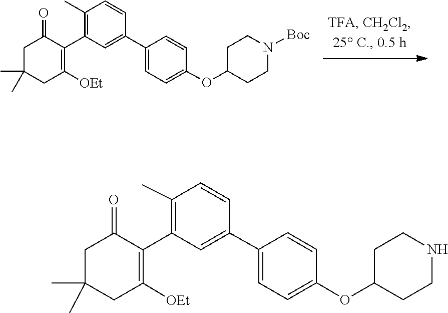 [SMILES: CCOC1=C(c2cc(-c3ccc(OC4CCN(C(=O)OC(C)(C)C)CC4)cc3)ccc2C)C(=O)CC(C)(C)C1 ; CCOC1=C(c2cc(-c3ccc(OC4CCNCC4)cc3)ccc2C)C(=O)CC(C)(C)C1]

To a mixture of tert-butyl 4-[4-[3-(2-ethoxy-4,4-dimethyl-6-oxo-cyclohexen-1-yl)-4-methyl-phenyl]-phenoxy]piperidine-1-carboxylate (1.05 g, 1.97 mmol, 99.9% purity in CH₂Cl₂ (2 mL) was added TFA (6.47 g, 56.73 mmol, 4.20 mL). The mixture was stirred at 25° C. for 0.5 hour. The mixture was concentrated in vacuo to afford 3-ethoxy-5,5-dimethyl-2-[2-methyl-5-[4-(4-piperidyloxy)phenyl]phenyl]cyclohex-2-en-1-one (1.08 g, TFA salt) as a yellow oil. LCMS: RT=0.759 min, m/z 434.3 [M+H]⁺.

### Example A-31: Synthesis of (2S)-2-[[2-[3-(4 hydroxyphenyl)propanoylamino]-2-methyl-propanoyl]amino]-3-methyl-N-[(1S)-2-methyl-1-(pyrrolidine-1-carbonyl)propyl]butanamide

### A. Step 1

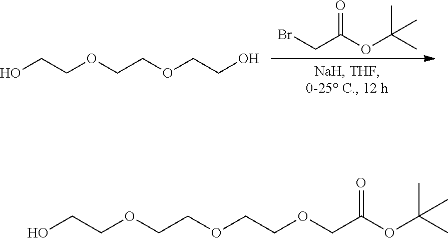

To a solution of 2-[2-(2-hydroxyethoxy)ethoxy]ethanol (15.40 g, 102.54 mmol, 13.75 mL) in THF (100 mL) was added NaH (2.26 g, 56.39 mmol, 60% purity) at 0° C. under N₂ and the mixture was stirred for 0.5 hour. Tert-butyl 2-bromoacetate (10 g, 51.27 mmol, 7.58 mL) was added to the mixture at 0° C. The reaction mixture was stirred at 25° C. for 12 hours under N₂. The mixture was poured into H₂O (500 mL) and extracted with Ethyl acetate (500 mL×2). The combined organic phase was dried over anhydrous Na₂SO₄, filtered, and concentrated in vacuo. The residue was purified by column chromatography (SiO₂, Petroleum ether/Ethyl acetate=3/1 to 1/1) to afford tert-butyl 2-[2-[2-(2-hydroxyethoxy)-ethoxy]ethoxy]acetate (3 g, 11.35 mmol, 22.14% yield) as colorless oil. HNMR: CDCl₃, 400 MHz. δ 4.01 (s, 2H), 3.74-3.68 (m, 6H), 3.68-3.65 (m, 4H), 3.62-3.58 (m, 2H), 1.46 (s, 9H).

### B. Step 2

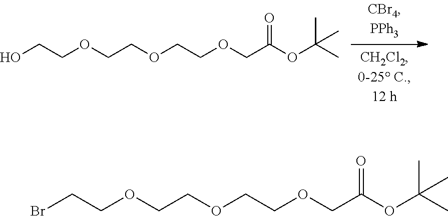 [SMILES: CC(C)(C)OC(=O)COCCOCCOCCO ; CC(C)(C)OC(=O)COCCOCCOCCBr]

To a solution of tert-butyl 2-[2-[2-(2-hydroxyethoxy)ethoxy]ethoxy]acetate (4.8 g, 18.16 mmol) and CBr₄ (6.02 g, 18.16 mmol) in CH₂Cl₂ (80 mL) was added PPh₃ (4.76 g, 18.16 mmol) at 0° C. The mixture was stirred at 25° C. for 12 hours. The reaction mixture was concentrated under reduced pressure and purified by column chromatography (SiO₂, Petroleum ether/Ethyl acetate=8/1 to 5/1) to afford tert-butyl 2-[2-[2-(2-bromoethoxy)ethoxy]ethoxy]acetate (2.6 g, 7.95 mmol, 43.75% yield) as a colorless oil. HNMR: CDCl₃, 400 MHz. δ 4.03 (s, 2H), 3.81 (t, J=6.4 Hz, 2H), 3.74-3.66 (m, 8H), 3.48 (t, J=6.4 Hz, 2H), 1.48 (s, 9H).

### C. Step 3

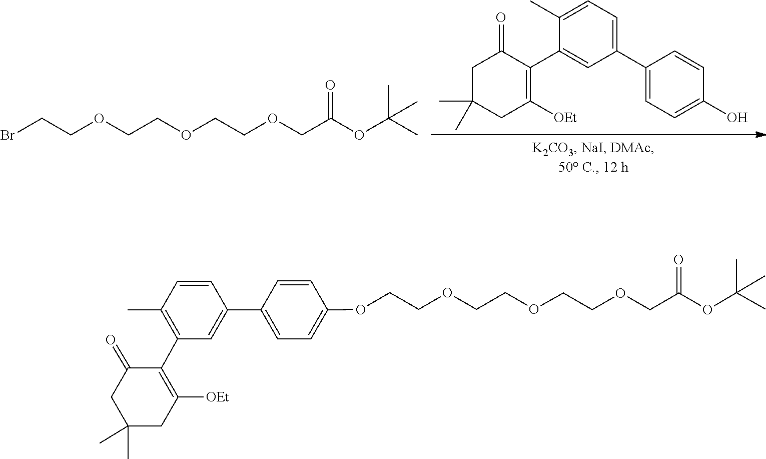

To a solution of 3-ethoxy-2-[5-(4-hydroxyphenyl)-2-methyl-phenyl]-5,5-dimethyl-cyclohex-2-en-1-one (Int. 1) (200 mg, 570.70 μmol) in DMAC (5 mL) were added NaI (85.54 mg, 570.70 μmol), tert-butyl 2-[2-[2-(2-bromoethoxy)ethoxy]ethoxy]acetate (224.09 mg, 684.83 μmol) and K₂CO₃ (157.75 mg, 1.14 mmol). The mixture was stirred at 50° C. for 12 hours. The reaction mixture was diluted with H₂O (40 mL) and extracted with Ethyl acetate (60 mL×3). The combined organic layers were washed with brine (80 mL×3), dried over anhydrous Na₂SO₄, filtered, and concentrated under reduced pressure. The residue was purified by column chromatography (SiO₂, Petroleum ether/Ethyl acetate=5/1 to 1/1) to afford tert-butyl 2-[2-[2-[2-[4-[3-(2-ethoxy-4,4-dimethyl-6-oxo-cyclohexen-1-yl)-4-methylphenyl]phenoxy]-ethoxy]ethoxy]ethoxy]acetate (140 mg, 234.60 μmol, 41.11% yield) as a colorless oil. LCMS: RT=1.060 min, m/z 541.1 [M-55]⁺.

### D. Step 4

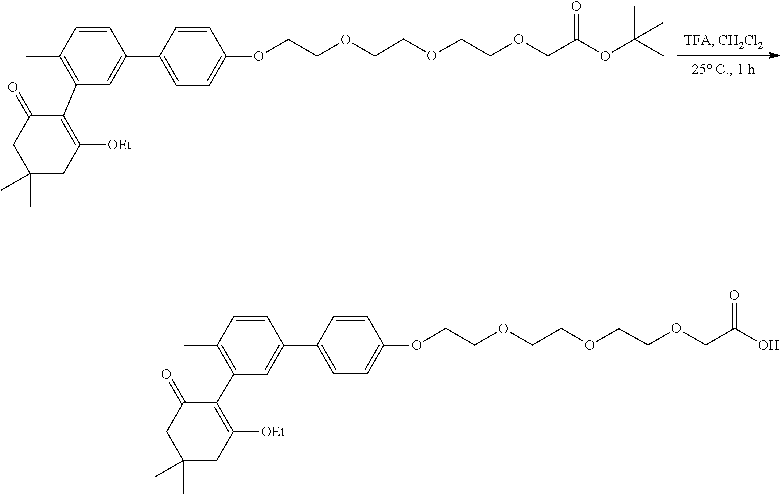

To a solution of tert-butyl 2-[2-[2-[2-[4-[3-(2-ethoxy-4,4-dimethyl-6-oxo-cyclohexen-1-yl)-4-methyl-phenyl]phenoxy]ethoxy]ethoxy]ethoxy]acetate (140 mg, 234.60 μmol) in CH₂Cl₂ (2 mL) was dropwise added TFA (0.4 mL). The mixture was stirred at 25° C. for 1 hour. The reaction mixture was concentrated under reduced pressure to afford the crude 2-[2-[2-[2-[4-[3-(2-ethoxy-4,4-dimethyl-6-oxo-cyclohexen-1-yl)-4-methylphenyl]phenoxy]ethoxy]ethoxy]-ethoxy]acetic acid (200 mg) as a yellow oil, which was used without further purification. LCMS: RT=0.941 min, m/z 541.1 [M+1]+.

### E. Step 5

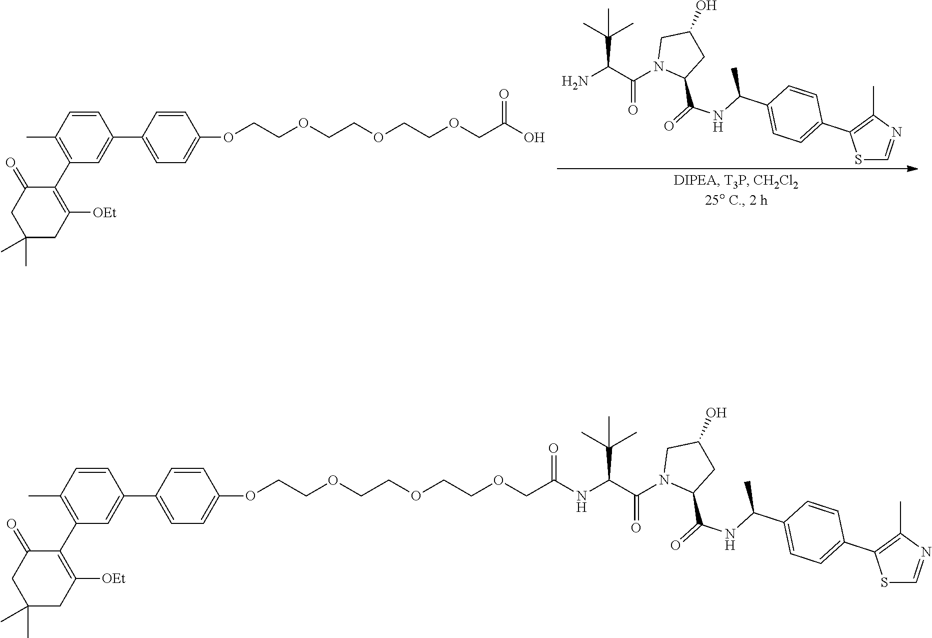 [SMILES: CCOC1=C(c2cc(-c3ccc(OCCOCCOCCOCC(=O)O)cc3)ccc2C)C(=O)CC(C)(C)C1 ; Cc1ncsc1-c1ccc([C@H](C)NC(=O)[C@@H]2C[C@@H](O)CN2C(=O)[C@@H](N)C(C)(C)C)cc1 ; CCOC1=C(c2cc(-c3ccc(OCCOCCOCCOCC(=O)N[C@H](C(=O)N4C[C@H](O)C[C@H]4C(=O)N[C@@H](C)c4ccc(-c5scnc5C)cc4)C(C)(C)C)cc3)ccc2C)C(=O)CC(C)(C)C1]

To a solution of 2-[2-[2-[2-[4-[3-(2-ethoxy-4,4-dimethyl-6-oxo-cyclohexen-1-yl)-4-methylphenyl]-phenoxy]ethoxy]ethoxy]ethoxy]acetic acid (200 mg, 369.93 μmol), DIPEA (191.24 mg, 1.48 mmol, 257.73 μL) and (2S,4R)-1-[(2S)-2-amino-3,3-dimethyl-butanoyl]-4-hydroxy-N-[(1S)-1-[4-(4-methylthiazol-5-yl)phenyl]ethyl]pyrrolidine-2-carboxamide (266.93 mg, 554.89 μmol, HCl salt) in CH₂Cl₂ (2 mL) was slowly added T₃P (353.11 mg, 554.89 μmol, 330.01 μL, 50% purity). The mixture was stirred at 25° C. for 2 hours. The reaction mixture was concentrated under reduced pressure. The residue was purified by column chromatography (SiO₂, CH₂Cl₂/MeOH=20/1) to afford (2S,4R)-1-[(2S)-2-[[2-[2-[2-[2-[4-[3-(2-ethoxy-4,4-dimethyl-6-oxo-cyclohexen-1-yl)-4-methyl-phenyl]phenoxy]ethoxy]ethoxy]ethoxy]acetyl]amino]-3,3-dimethyl-butanoyl]-4-hydroxy-N-[(1S)-1-[4-(4-methylthiazol-5-yl)phenyl]ethyl]pyrrolidine-2-carboxamide (230 mg, 237.80 μmol, 64.28% yield) as a yellow oil. LCMS: RT=1.016 min, m/z 967.6 [M+H]⁺.

### F. Step 6

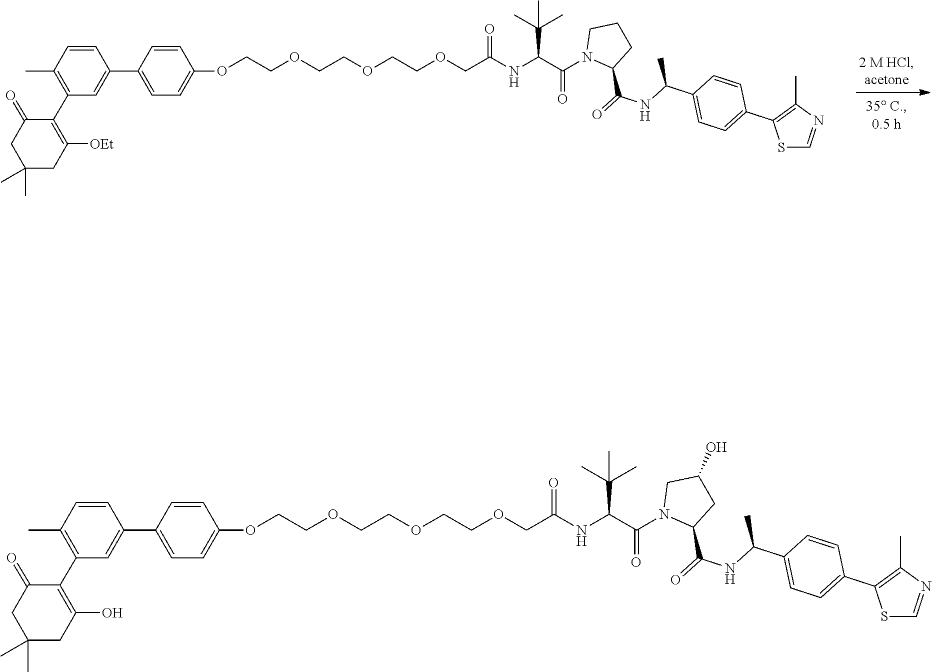 [SMILES: CCOC1=C(c2cc(-c3ccc(OCCOCCOCCOCC(=O)N[C@H](C(=O)N4CCC[C@H]4C(=O)N[C@@H](C)c4ccc(-c5scnc5C)cc4)C(C)(C)C)cc3)ccc2C)C(=O)CC(C)(C)C1 ; Cc1ccc(-c2ccc(OCCOCCOCCOCC(=O)N[C@H](C(=O)N3C[C@H](O)C[C@H]3C(=O)N[C@@H](C)c3ccc(-c4scnc4C)cc3)C(C)(C)C)cc2)cc1C1=C(O)CC(C)(C)CC1=O]

To a solution of (2S,4R)-1-[(2S)-2-[[2-[2-[2-[2-[4-[3-(2-ethoxy-4,4-dimethyl-6-oxo-cyclohexen-1-yl)-4-methylphenyl]phenoxy]ethoxy]ethoxy]ethoxy]acetyl]amino]-3,3-dimethyl-butanoyl]-4-hydroxy-N-[(1S)-1-[4-(4-methylthiazol-5-yl)phenyl]ethyl]pyrrolidine-2-carboxamide (210 mg, 217.12 μmol) in acetone (5 mL) was added HCl aqueous (2 M, 10.5 mL). The mixture was stirred at 35° C. for 0.5 hour. The reaction mixture was diluted with H₂O (10 mL) and extracted with Ethyl acetate (30 mL×3). The combined organic layers were dried over anhydrous Na₂SO₄, filtered and concentrated under reduced pressure. The residue was purified by prep-HPLC (FA condition, column: Phenomenex luna C18 150*25 mm*10 μm; mobile phase: [water(0.225% FA)-ACN]; B %: 48%-78%, 10 min) to afford (2S,4R)-4-hydroxy-1-[(2S)-2-[[2-[2-[2-[2-[4-[3-(2-hydroxy-4,4-dimethyl-6-oxo-cyclohexen-1-yl)-4-methylphenyl]phenoxy]ethoxy]ethoxy]ethoxy]-acetyl]amino]-3,3-dimethyl-butanoyl]-N-[(1S)-1-[4-(4-methylthiazol-5-yl)phenyl]ethyl]pyrrolidine-2-carboxamide (101.44 mg, 108.01 μmol, 49.75% yield, 99.9% purity) as a white solid. HNMR: DMSO-d₆, 400 MHz. δ 8.98 (s, 1H), 8.45 (d, J=7.6 Hz, 1H), 7.50 (d, J=8.8 Hz, 2H), 7.44-7.34 (m, 6H), 7.21-7.15 (m, 1H), 7.10-7.05 (m, 1H), 6.99 (d, J=8.8 Hz, 2H), 5.17-5.10 (m, 1H), 4.93-4.86 (m, 1H), 4.55 (d, J=9.6 Hz, 1H), 4.45-4.40 (m, 1H), 4.31-4.25 (m, 1H), 4.13-4.10 (m, 2H), 3.96 (s, 2H), 3.78-3.75 (m, 2H), 3.65-3.57 (m, 10H), 2.45 (s, 3H), 2.41-2.29 (m, 4H), 2.08-2.00 (m, 4H), 1.80-1.73 (m, 1H), 1.35 (d, J=6.8 Hz, 3H), 1.10 (d, J=2.4 Hz, 6H), 0.94 (s, 9H). LCMS: =2.459 min, m/z 939.5 [M+H]⁺.

### Example A-32: Synthesis of (2S,4R)-4-hydroxy-1-[(2S)-2-[[2-[2-[2-[2-[2-[4-[3-(2-hydroxy-4,4-dimethyl-6-oxo-cyclohexen-1-yl)-4-methylphenyl]phenoxy]ethoxy]ethoxy]ethoxy]ethoxy]acetyl]-amino]-3,3-dimethyl-butanoyl]-N-[(1S)-1-[4-(4-methylthiazol-5-yl)phenyl]ethyl]pyrrolidine-2-carboxamide

The compound of Example A-32 was prepared using general procedures described in Example A-31.

HNMR: DMSO-d6, 400 MHz. δ 8.97 (s, 1H), 8.45 (d, J=8.0 Hz, 1H), 7.50-7.33 (m, 8H), 7.18 (d, J=8.0 Hz, 1H), 7.09 (d, J=2.0 Hz, 1H), 6.99 (d, J=8.0 Hz, 2H), 4.92-4.84 (m, 1H), 4.57-4.52 (m, 1H), 4.47-4.41 (m, 1H), 4.29 (s, 1H), 4.13-4.09 (m, 2H), 3.96 (s, 2H), 3.77-3.74 (m, 2H), 3.61-3.55 (m, 13H), 2.46-2.44 (m, 3H), 2.40-2.24 (m, 5H), 2.08-2.02 (m, 4H), 1.80-1.72 (m, 1H), 1.46-1.35 (m, 3H), 1.09 (d, J=2.4 Hz, 6H), 0.93 (s, 9H). LCMS: RT=2.488 min, m/z 983.4 [M+H]⁺.

### Example A-33: Synthesis of (2S,4R)-4-hydroxy-1-[(2S)-2-[[2-[2-[2-[2-[2-[2-[4-[3-(2-hydroxy-4,4-dimethyl-6-oxo-cyclohexen-1-yl)-4-methyl-phenyl]phenoxy]ethoxy]ethoxy]ethoxy]ethoxy]ethoxy]acetyl]amino]-3,3-dimethyl-butanoyl]-N-[(1S)-1-[4-(4-methylthiazol-5-yl)phenyl]ethyl]pyrrolidine-2-carboxamide

The compound of Example A-33 was prepared using general procedures described in Example A-31.

HNMR: DMSO-d6, 400 MHz. δ 8.98 (s, 1H), 8.44 (d, J=8.0 Hz, 1H), 7.50 (d, J=8.8 Hz, 2H), 7.45-7.41 (m, 2H), 7.40-7.33 (m, 4H), 7.20 (d, J=8.0 Hz, 1H), 7.09 (d, J=2.0 Hz, 1H), 6.99 (d, J=8.8 Hz, 2H), 4.95-4.84 (m, 1H), 4.54 (d, J=9.6 Hz, 1H), 4.44 (t, J=8.0 Hz, 1H), 4.31-4.24 (m, 1H), 4.15-4.06 (m, 2H), 3.98-3.89 (m, 2H), 3.77-3.73 (m, 2H), 3.62-3.51 (m, 18H), 2.45 (s, 3H), 2.42-2.27 (m, 4H), 2.08-2.00 (m, 4H), 1.83-1.70 (m, 1H), 1.48-1.32 (m, 3H), 1.14-1.07 (m, 6H), 0.96-0.91 (m, 9H). LCMS: RT=2.459 min, m/z 1027.5 [M+H]⁺.

### Example A-34: Synthesis of (2S,4R)-4-hydroxy-1-[(2S)-2-[[2-[2-[2-[2-[2-[2-[2-[4-[3-(2-hydroxy-4,4-dimethyl-6-oxo-cyclohexen-1-yl)-4-methyl-phenyl]phenoxy]ethoxy]ethoxy]ethoxy]ethoxy]ethoxy]ethoxy]acetyl]amino]-3,3-dimethyl-butanoyl]-N-[(1S)-1-[4-(4-methylthiazol-5-yl)phenyl]ethyl]pyrrolidine-2-carboxamide

The compound of Example A-34 was prepared using general procedures described in Example A-31.

HNMR: CDCl₃, 400 MHz. δ 8.60 (s, 1H), 7.48-7.31 (m, 10H), 7.23 (d, J=2.0 Hz, 1H), 6.96-6.92 (m, 2H), 5.12-5.02 (m, 1H), 4.73 (t, J=8.0 Hz, 1H), 4.54-4.44 (m, 2H), 4.18-4.13 (m, 2H), 4.11-3.94 (m, 3H), 3.90-3.85 (m, 2H), 3.76-3.71 (m, 2H), 3.69-3.62 (m, 18H), 3.56 (dd, J=3.6, 11.2 Hz, 1H), 3.15-2.99 (m, 1H), 2.57-2.37 (m, 8H), 2.17 (s, 3H), 2.09-2.01 (m, 1H), 1.47 (d, J=6.8 Hz, 3H), 1.23-1.18 (m, 6H), 1.06 (s, 9H). LCMS: RT=2.468 min, m/z 1071.5 [M+H]⁺.

### Example A-35: Synthesis of (2S)-2-[[2-[3-(4-hydroxyphenyl)propanoylamino]-2-methyl-propanoyl]amino]-3-methyl-N-[(1S)-2-methyl-1-(pyrrolidine-1-carbonyl)propyl]butanamide

### A. Step 1

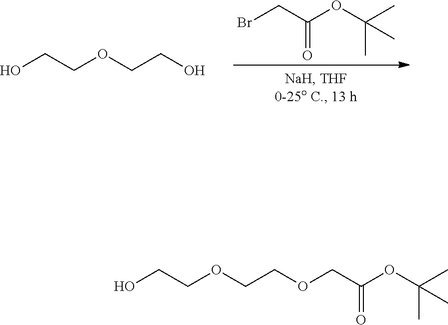

To a mixture of 2-(2-hydroxyethoxy)ethanol (21.76 g, 205.07 mmol, 19.43 mL) in THF (300 mL) was added NaH (4.51 g, 112.79 mmol, 60% purity) at 0° C. under N₂ and stirred at 0° C. for 1 hour. To the mixture was added tert-butyl 2-bromoacetate (20 g, 102.54 mmol, 15.15 mL) and stirred at 25° C. for 12 hours. The mixture was poured into water (200 mL) and extracted with EtOAc (200 mL×3). The organic phase was washed with brine (200 mL), dried over anhydrous Na₂SO₄, filtered, and concentrated in vacuo. The residue was purified by column chromatography (SiO₂, PE:EtOAc=10:1 to 1:1) to afford tert-butyl 2-[2-(2-hydroxyethoxy)ethoxy]acetate (2.2 g, 9.99 mmol, 9.74% yield) as a colorless oil. HNMR: CDCl₃, 400 MHz. δ 4.03-3.98 (m, 2H), 3.76-3.72 (m, 2H), 3.71 (s, 4H), 3.64-3.60 (m, 2H), 1.48 (s, 9H)

### B. Step 2

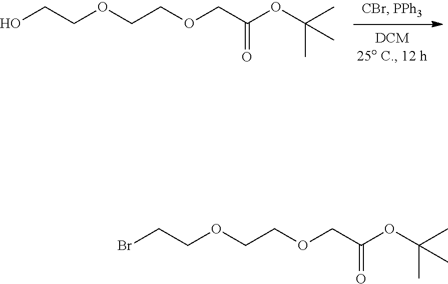

To a mixture of tert-butyl 2-[2-(2-hydroxyethoxy)ethoxy]acetate (3 g, 13.62 mmol) in DCM (50 mL) was added carbon tetrabromide (9.03 g, 27.24 mmol), followed by PPh₃ (7.14 g, 27.24 mmol). The mixture was stirred at 25° C. for 12 hours. The mixture was concentrated under reduced pressure and the residue was purified by column chromatography (SiO₂, PE:EtOAc=1:0 to 20:1) to afford tert-butyl 2-[2-(2-bromoethoxy)ethoxy]acetate (0.86 g, 3.04 mmol, 22.30% yield) as a yellow oil. HNMR: CDCl₃, 400 MHz. δ 4.05-4.00 (m, 2H), 3.83 (t, J=6.4 Hz, 2H), 3.74-3.68 (m, 4H), 3.49 (t, J=6.4 Hz, 2H), 1.48 (s, 9H).

### C. Step 3

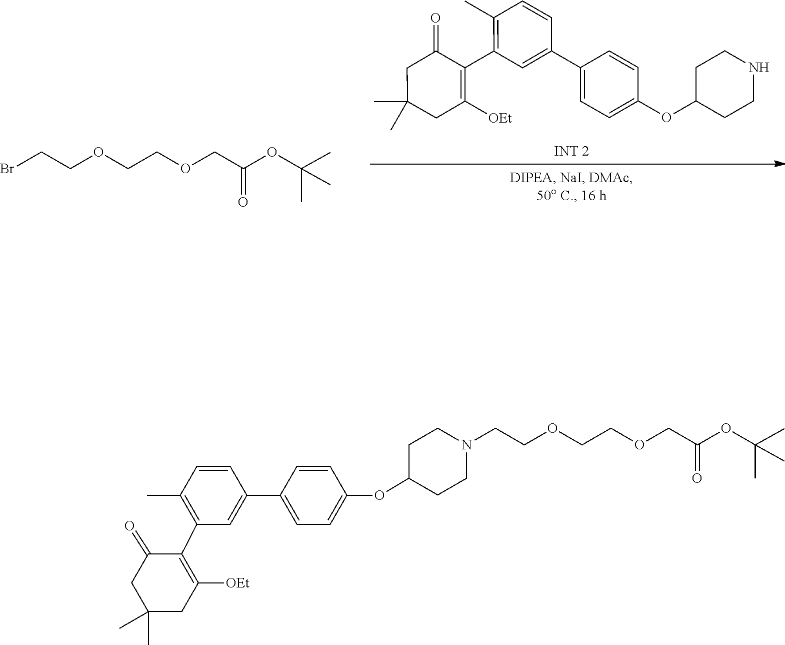 [SMILES: CCOC1=C(c2cc(-c3ccc(OC4CCNCC4)cc3)ccc2C)C(=O)CC(C)(C)C1 ; CC(C)(C)OC(=O)COCCOCCBr ; CCOC1=C(c2cc(-c3ccc(OC4CCN(CCOCCOCC(=O)OC(C)(C)C)CC4)cc3)ccc2C)C(=O)CC(C)(C)C1]

To a mixture of 3-ethoxy-5,5-dimethyl-2-[2-methyl-5-[4-(4-piperidyloxy)phenyl]phenyl]cyclohex-2-en-1-one (INT 2) (0.154 g, 281.23 μmol, TFA) in DMAC (2 mL) were added tert-butyl 2-[2-(2-bromo-ethoxy)ethoxy]acetate (119.45 mg, 421.85 μmol), NaI (21.08 mg, 140.62 μmol) and K₂CO₃ (116.60 mg, 843.69 μmol). The mixture was stirred at 50° C. for 16 hours. EtOAc (20 mL) and water (20 mL) were added, and layers were separated. The aqueous phase was extracted with EtOAc (10 mL×3). The combined extracts were washed with brine (20 mL), dried over Na₂SO₄, filtered, and concentrated under vacuum. The residue was purified by flash silica gel chromatography (ISCO®; 12 g SepaFlash® Silica Flash Column, Eluent of 0-10% DCM:MeOH @30 mL/min) to afford 2-[2-[2-[4-[4-[3-(2-ethoxy-4,4-dimethyl-6-oxo-cyclohexen-1-yl)-4-methyl-phenyl]phenoxy]-1-piperidyl]ethoxy]ethoxy]acetate (130 mg, 204.46 μmol, 72.70% yield) as a colorless gum. LCMS: RT=0.927 min, m/z 636.6 [M+H]⁺.

### D. Step 4

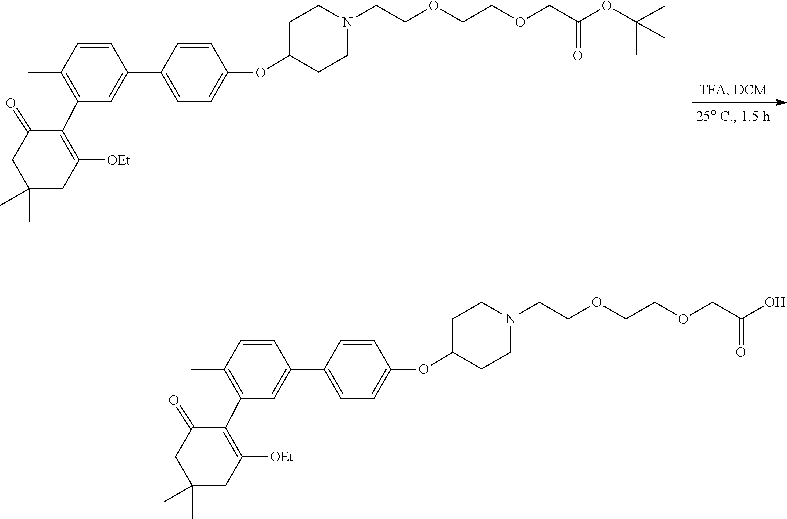

To a mixture of tert-butyl 2-[2-[2-[4-[4-[3-(2-ethoxy-4,4-dimethyl-6-oxo-cyclohexen-1-yl)-4-methyl-phenyl]phenoxy]-1-piperidyl]ethoxy]ethoxy]acetate (130 mg, 204.46 μmol) in DCM (3 mL) was added TFA (4.62 g, 40.52 mmol, 3 mL). The mixture was stirred at 25° C. for 1.5 hours. The solvent was evaporated under reduced pressure to afford 2-[2-[2-[4-[4-[3-(2-ethoxy-4,4-dimethyl-6-oxo-cyclohexen-1-yl)-4-methyl-phenyl]phenoxy]-1-piperidyl]ethoxy]ethoxy]acetic acid (110 mg, crude) as a yellow oil. LCMS: RT=0.766 min, m/z 580.2 [M+H]⁺.

### E. Step 5

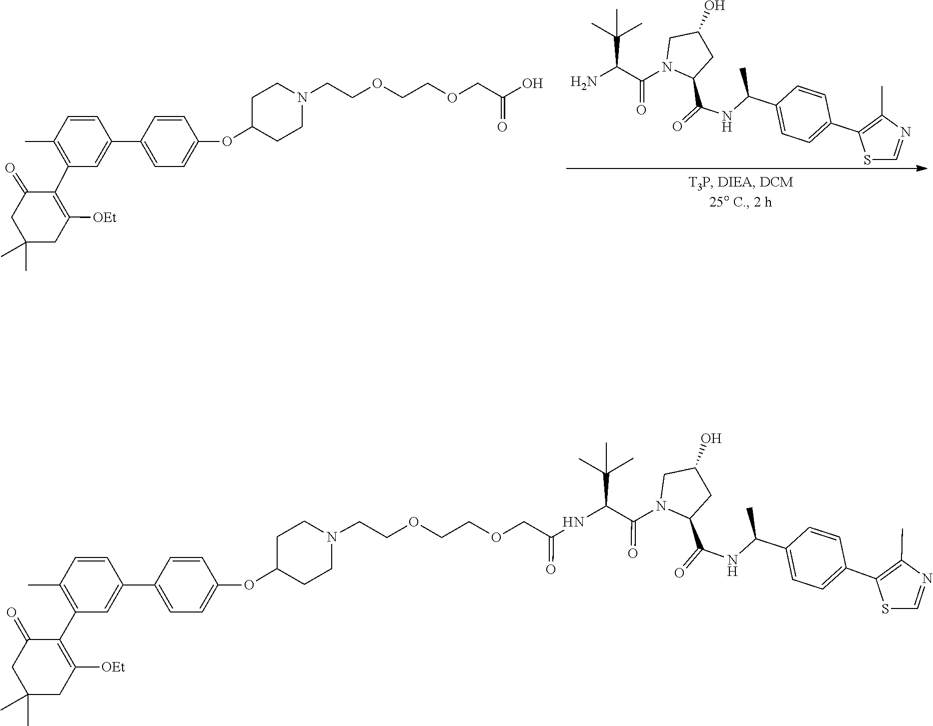 [SMILES: CCOC1=C(c2cc(-c3ccc(OC4CCN(CCOCCOCC(=O)O)CC4)cc3)ccc2C)C(=O)CC(C)(C)C1 ; Cc1ncsc1-c1ccc([C@H](C)NC(=O)[C@@H]2C[C@@H](O)CN2C(=O)[C@@H](N)C(C)(C)C)cc1 ; CCOC1=C(c2cc(-c3ccc(OC4CCN(CCOCCOCC(=O)N[C@H](C(=O)N5C[C@H](O)C[C@H]5C(=O)N[C@@H](C)c5ccc(-c6scnc6C)cc5)C(C)(C)C)CC4)cc3)ccc2C)C(=O)CC(C)(C)C1]

To a mixture of 2-[2-[2-[4-[4-[3-(2-ethoxy-4,4-dimethyl-6-oxo-cyclohexen-1-yl)-4-methyl-phenyl]phenoxy]-1-piperidyl]ethoxy]ethoxy]acetic acid (110 mg, 189.75 μmol, crude) in DCM (5 mL) were added (2S,4R)-1-[(2S)-2-amino-3,3-dimethyl-butanoyl]-4-hydroxy-N-[(1S)-1-[4-(4-methylthiazol-5-yl)phenyl]ethyl]pyrrolidine-2-carboxamide (182.55 mg, 379.49 μmol, HCl salt), T₃P (181.12 mg, 284.62 μmol, 169.27 μL, 50% purity) and DIPEA (98.09 mg, 758.98 μmol, 132.20 μL). The mixture was stirred at 25° C. for 2 hours. The solvent was evaporated under reduced pressure. The residue was purified by flash silica gel chromatography (ISCO®; 12 g SepaFlash® Silica Flash Column, Eluent of 0-20% DCM:MeOH@30 mL/min) to afford (2S,4R)-1-[(2S)-2-[[2-[2-[2-[4-[4-[3-(2-ethoxy-4,4-dimethyl-6-oxo-cyclohexen-1-yl)-4-methyl-phenyl]phenoxy]-1-piperidyl]ethoxy]ethoxy]acetyl]amino]-3,3-dimethyl-butanoyl]-4-hydroxy-N-[(1S)-1-[4-(4-methylthiazol-5-yl)phenyl]ethyl]pyrrolidine-2-carboxamide (117 mg, 116.27 μmol, 61.28% yield) as a colorless gum. LCMS: RT=2.066 min, m/z 1006.7 [M+H]⁺.

### F. Step 6

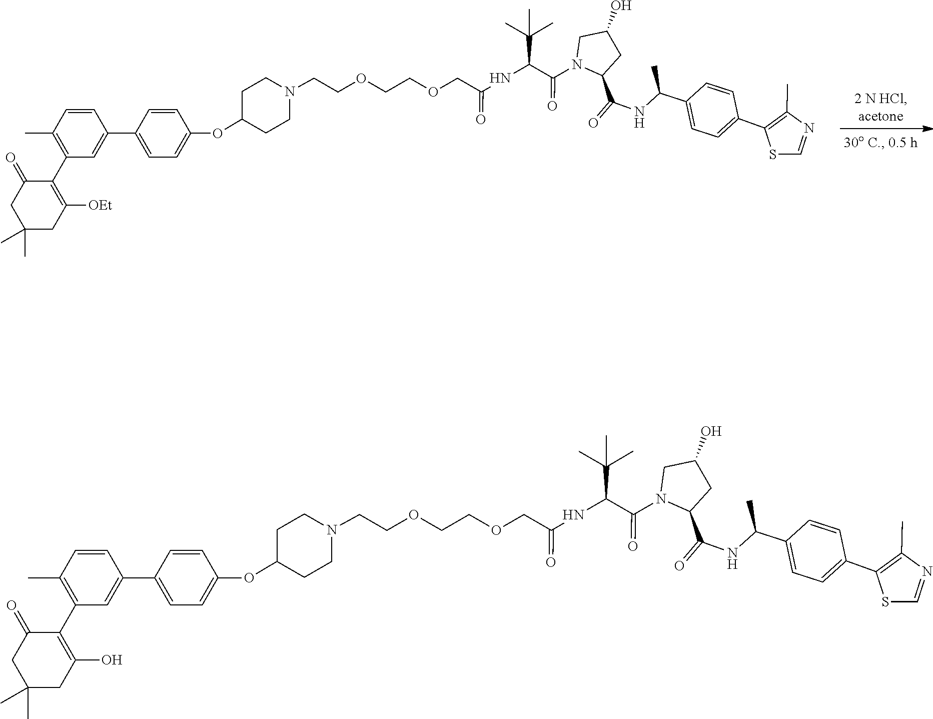 [SMILES: CCOC1=C(c2cc(-c3ccc(OC4CCN(CCOCCOCC(=O)N[C@H](C(=O)N5C[C@H](O)C[C@H]5C(=O)N[C@@H](C)c5ccc(-c6scnc6C)cc5)C(C)(C)C)CC4)cc3)ccc2C)C(=O)CC(C)(C)C1 ; Cc1ccc(-c2ccc(OC3CCN(CCOCCOCC(=O)N[C@H](C(=O)N4C[C@H](O)C[C@H]4C(=O)N[C@@H](C)c4ccc(-c5scnc5C)cc4)C(C)(C)C)CC3)cc2)cc1C1=C(O)CC(C)(C)CC1=O]

To a mixture of (2S,4R)-1-[(2S)-2-[[2-[2-[2-[4-[4-[3-(2-ethoxy-4,4-dimethyl-6-oxo-cyclohexen-1-yl)-4-methyl-phenyl]phenoxy]-1-piperidyl]ethoxy]ethoxy]acetyl]amino]-3,3-dimethyl-butanoyl]-4-hydroxy-N-[(1S)-1-[4-(4-methylthiazol-5-yl)phenyl]ethyl]pyrrolidine-2-carboxamide (100 mg, 99.37 μmol) in acetone (1.5 mL) was added HCl aqueous (2 M, 3 mL). The mixture was stirred at 30° C. for 0.5 hour. The solvent was evaporated under reduced pressure. The crude product was purified by prep-HPLC (column: Phenomenex luna C18 150*25 mm*10 μm; mobile phase: [water (0.225% FA)-ACN]; B %: 18%-48%, 10 min) to afford (2S,4R)-4-hydroxy-1-[(2S)-2-[[2-[2-[2-[4-[4-[3-(2-hydroxy-4,4-dimethyl-6-oxo-cyclohexen-1-yl)-4-methyl-phenyl]phenoxy]-1-piperidyl]ethoxy]ethoxy]acetyl]amino]-3,3-dimethyl-butanoyl]-N-[(1S)-1-[4-(4-methylthiazol-5-yl)phenyl]ethyl]pyrrolidine-2-carboxamide (17.74 mg, 18.13 μmol, 18.25% yield, 99.9% purity) as an off-white solid. HNMR: DMSO-d₆, 400 MHz. δ 8.97 (s, 1H), 8.42 (d, J=7.6 Hz, 1H), 8.16 (s, 1H), 7.49-7.32 (m, 8H), 7.18 (d, J=7.6 Hz, 1H), 7.10-7.05 (m, 1H), 6.98 (d, J=8.4 Hz, 2H), 4.93-4.84 (m, 1H), 4.58-4.51 (m, 1H), 4.47-4.42 (m, 1H), 4.41-4.34 (m, 1H), 4.32-4.22 (m, 1H), 3.98-3.90 (m, 2H), 3.65-3.51 (m, 9H), 2.78-2.70 (m, 2H), 2.68-2.66 (m, 1H), 2.44 (s, 3H), 2.41-2.27 (m, 8H), 2.05-2.03 (s, 3H), 1.97-1.74 (m, 4H), 1.66-1.59 (m, 2H), 1.37-1.35 (m, 2H), 1.10 (s, 6H), 0.94 (s, 9H). LCMS: RT=2.190 min, m/z 977.5 [M+H]⁺.

### Example A-36: Synthesis of (2S,4R)-4-hydroxy-1-[(2S)-2-[[2-[2-[2-[2-[4-[4-[3-(2-hydroxy-4,4-dimethyl-6-oxo-cyclohexen-1-yl)-4-methylphenyl]phenoxy]-1-piperidyl]ethoxy]ethoxy]ethoxy]acetyl]amino]-3,3-dimethyl-butanoyl]-N-[(1S)-1-[4-(4-methylthiazol-5-yl)phenyl]ethyl]pyrrolidine-2-carboxamide

The compound of Example A-36 was prepared using general procedures described in Example A-35.

HNMR: DMSO-d6, 400 MHz. δ 8.98 (s, 1H), 8.44 (d, J=7.6 Hz, 1H), 8.15 (s, 1H), 7.50-7.32 (m, 8H), 7.19 (d, J=8.0 Hz, 1H), 7.07 (d, J=2.0 Hz, 1H), 6.98 (d, J=8.8 Hz, 2H), 5.15-5.08 (m, 1H), 4.93-4.86 (m, 1H), 4.54 (d, J=9.6 Hz, 1H), 4.44 (t, J=8.0 Hz, 1H), 4.41-4.33 (m, 1H), 4.30-4.00 (m, 1H), 3.98-3.91 (m, 2H), 3.64-3.48 (m, 14H), 2.81-2.70 (m, 2H), 2.45 (s, 3H), 2.40-2.26 (m, 6H), 2.09-1.99 (m, 4H), 1.98-1.89 (m, 2H), 1.83-1.71 (m, 1H), 1.69-1.56 (m, 2H), 1.37 (d, J=7.2 Hz, 3H), 1.13-1.00 (m, 6H), 0.94 (s, 9H). LCMS: RT=2.413 min, m/z 1022.7 [M+H]⁺.

### Example A-37: Synthesis of (2S,4R)-4-hydroxy-1-[(2S)-2-[[2-[2-[2-[2-[2-[4-[4-[3-(2-hydroxy-4,4-dimethyl-6-oxo-cyclohexen-1-yl)-4-methyl-phenyl]phenoxy]-1-piperidyl]ethoxy]ethoxy]ethoxy]ethoxy]acetyl]amino]-3,3-dimethyl-butanoyl]-N-[(1S)-1-[4-(4-methylthiazol-5-yl)phenyl]ethyl]pyrrolidine-2-carboxamide

The compound of Example A-37 was prepared using general procedures described in Example A-35.

HNMR: DMSO-d6, 400 MHz. δ 8.98 (s, 1H), 8.44 (d, J=8.0 Hz, 1H), 8.16 (s, 1H), 7.50-7.41 (m, 4H), 7.41-7.33 (m, 4H), 7.19 (d, J=8.0 Hz, 1H), 7.08 (d, J=2.0 Hz, 1H), 6.98 (d, J=8.8 Hz, 2H), 5.23-5.00 (m, 1H), 4.95-4.86 (m, 1H), 4.54 (d, J=9.6 Hz, 1H), 4.48-4.34 (m, 2H), 4.31-4.21 (m, 1H), 3.96 (s, 2H), 3.61-3.51 (m, 16H), 2.81-2.72 (m, 2H), 2.55-2.51 (m, 2H), 2.45 (s, 3H), 2.40-2.28 (m, 6H), 2.09-2.00 (m, 4H), 1.98-1.90 (m, 2H), 1.81-1.73 (m, 1H), 1.69-1.58 (m, 2H), 1.37 (d, J=6.8 Hz, 3H), 1.14-1.06 (m, 6H), 0.98-0.90 (m, 9H). LCMS: RT=2.241 min, m/z 1066.5 [M+H]⁺.

### Example A-38: Synthesis of (2S,4R)-4-hydroxy-1-[(2S)-2-[[2-[2-[2-[2-[2-[2-[4-[4-[3-(2-hydroxy-4,4-dimethyl-6-oxo-cyclohexen-1-yl)-4-methylphenyl]phenoxy]-1-piperidyl]ethoxy]ethoxy]ethoxy]ethoxy]-ethoxy]acetyl]amino]-3,3-dimethyl-butanoyl]-N-[(1S)-1-[4-(4-methylthiazol-5-yl)phenyl]-ethyl]pyrrolidine-2-carboxamide

The compound of Example A-38 was prepared using general procedures described in Example A-35.

HNMR: CDCl3, 400 MHz. δ 8.61 (s, 1H), 8.45 (brs, 1H), 7.52 (d, J=8.0 Hz, 1H), 7.46-7.44 (m, 2H), 7.41-7.29 (m, 7H), 7.22 (d, J=1.6 Hz, 1H), 6.88-6.86 (m, 2H), 5.08 (q, J=7.2 Hz, 1H), 4.72 (t, J=8.0 Hz, 1H), 4.57 (d, J=8.8 Hz, 1H), 4.47 (brs, 2H), 4.02-4.00 (m, 3H), 3.77 (t, J=4.8 Hz, 2H), 3.67-3.60 (m, 18H), 3.05-3.03 (m, 3H), 2.97-2.96 (m, 2H), 2.50-2.47 (m, 8H), 2.18-1.99 (m, 8H), 1.48 (d, J=7.2 Hz, 3H), 1.21 (d, J=3.2 Hz, 6H), 1.05 (s, 9H). LCMS:RT=2.136 min, m/z 1110.4 [M+H]⁺.

### Example A-39: Synthesis of (2S)-2-[[2-[3-(4-hydroxyphenyl)propanoylamino]-2-methyl-propanoyl]amino]-3-methyl-N-[(1S)-2-methyl-1-(pyrrolidine-1-carbonyl)propyl]butanamide

### A. Step 1

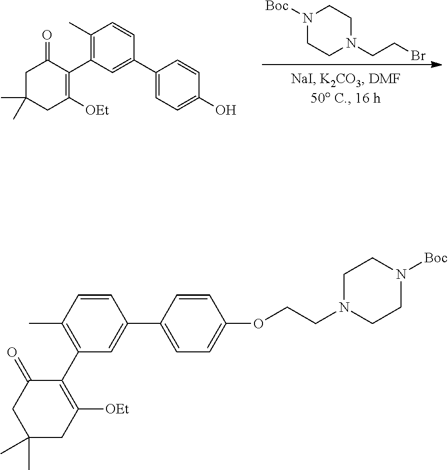 [SMILES: CCOC1=C(c2cc(-c3ccc(O)cc3)ccc2C)C(=O)CC(C)(C)C1 ; CC(C)(C)OC(=O)N1CCN(CCBr)CC1 ; CCOC1=C(c2cc(-c3ccc(OCCN4CCN(C(=O)OC(C)(C)C)CC4)cc3)ccc2C)C(=O)CC(C)(C)C1]

A mixture of 3-ethoxy-2-[5-(4-hydroxyphenyl)-2-methyl-phenyl]-5,5-dimethyl-cyclohex-2-en-1-one (562 mg, 1.60 mmol), tert-butyl 4-(2-bromoethyl)piperazine-1-carboxylate (940.38 mg, 3.21 mmol), NaI (240.38 mg, 1.60 mmol), K₂CO₃ (443.27 mg, 3.21 mmol) in DMF (10 mL) was degassed and purged with N₂, and then the mixture was stirred at 50° C. for 16 hours under N₂ atmosphere. The reaction mixture was quenched with water (200 mL) and extracted with CH₂Cl₂ (50 mL×3). The combined organic layers were dried over anhydrous Na₂SO₄, filtered, and concentrated under reduced pressure. The residue was purified by column chromatography (SiO₂, Petroleum ether/Ethyl acetate=50/1 to 1/4) to afford tert-butyl 4-[2-[4-[3-(2-ethoxy-4,4-dimethyl-6-oxo-cyclohexen-1-yl)-4-methyl-phenyl]phenoxy]ethyl]-piperazine-1-carboxylate (0.627 g, 1.08 mmol, 67.39% yield, 97% purity) as a yellow oil. HNMR: CDCl₃, 400 MHz. δ 7.54-7.46 (m, 2H), 7.41-7.34 (m, 1H), 7.26-7.21 (m, 1H), 7.19-7.14 (m, 1H), 6.97-6.89 (m, 2H), 3.97-3.82 (m, 2H), 3.51-3.41 (m, 4H), 2.87-2.79 (m, 2H), 2.59-2.50 (m, 6H), 2.43-2.35 (m, 2H), 2.19-2.09 (m, 3H), 2.07-2.01 (m, 2H), 1.51-1.43 (m, 9H). LCMS: RT=0.906 min, m/z 563.6 [M+H]⁺.

### B. Step 2

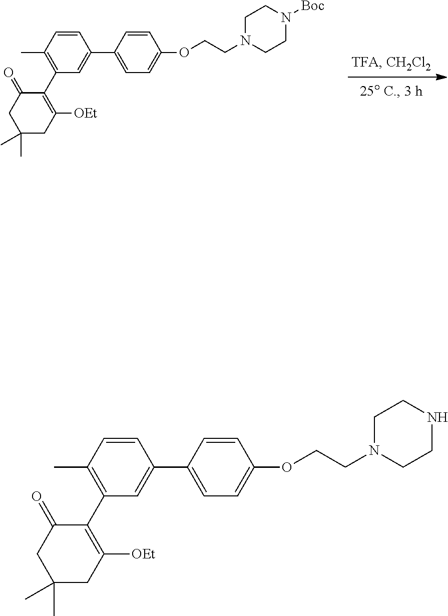 [SMILES: CCOC1=C(c2cc(-c3ccc(OCCN4CCN(C(=O)OC(C)(C)C)CC4)cc3)ccc2C)C(=O)CC(C)(C)C1 ; CCOC1=C(c2cc(-c3ccc(OCCN4CCNCC4)cc3)ccc2C)C(=O)CC(C)(C)C1]

A mixture of tert-butyl 4-[2-[4-[3-(2-ethoxy-4,4-dimethyl-6-oxo-cyclohexen-1-yl)-4-methyl-phenyl]-phenoxy]ethyl]piperazine-1-carboxylate (0.627 g, 1.08 mmol, 97% purity) in TFA (2 mL) and CH₂Cl₂ (2 mL) was degassed and purged with N₂, and then the mixture was stirred at 25° C. for 3 hours under N₂ atmosphere. The reaction mixture was concentrated under reduced pressure to afford crude 3-ethoxy-5,5-dimethyl-2-[2-methyl-5-[4-(2-piperazin-1-ylethoxy)phenyl]phenyl]cyclohex-2-en-1-one (0.883 g, TFA salt) as a yellow oil, which was used without further purification. LCMS: RT=0.700 min, m/z 463.3 [M+H]⁺.

### C. Step 3

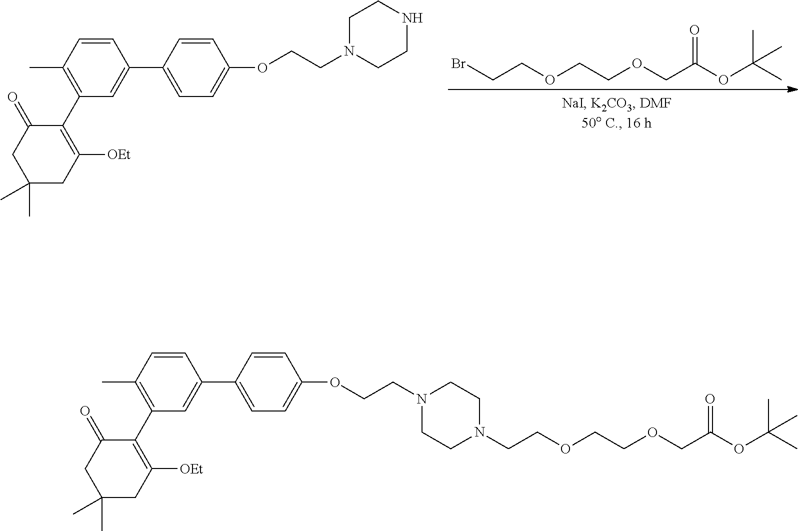 [SMILES: CCOC1=C(c2cc(-c3ccc(OCCN4CCNCC4)cc3)ccc2C)C(=O)CC(C)(C)C1 ; CC(C)(C)OC(=O)COCCOCCBr ; CCOC1=C(c2cc(-c3ccc(OCCN4CCN(CCOCCOCC(=O)OC(C)(C)C)CC4)cc3)ccc2C)C(=O)CC(C)(C)C1]

A mixture of tert-butyl 2-[2-(2-bromoethoxy)ethoxy]acetate (196 mg, 692.19 μmol), 3-ethoxy-5,5-dimethyl-2-[2-methyl-5-[4-(2-piperazin-1-ylethoxy)phenyl]phenyl]cyclohex-2-en-1-one (274 mg, 475.16 μmol, TFA salt), NaI (51.88 mg, 346.10 μmol), K₂CO₃ (143.50 mg, 1.04 mmol) in DMF (5 mL) was degassed and purged with N₂, and then the mixture was stirred at 50° C. for 16 hours under N₂ atmosphere. The reaction mixture was quenched by addition of water (150 mL) and extracted with CH₂Cl₂ (20 mL×3). The combined organic layers were dried over Na₂SO₄, filtered, and concentrated under reduced pressure. The residue was purified by column chromatography (SiO₂, CH₂Cl₂/MeOH=100/1 to 10/1) to afford tert-butyl 2-[2-[2-[4-[2-[4-[3-(2-ethoxy-4,4-dimethyl-6-oxo-cyclohexen-1-yl)-4-methyl-phenyl]phenoxy]ethyl]-piperazin-1-yl]ethoxy]ethoxy]-acetate (337 mg) as a yellow oil. LCMS: RT=0.798 min, m/z 665.3 [M+H]⁺.

### D. Step 4

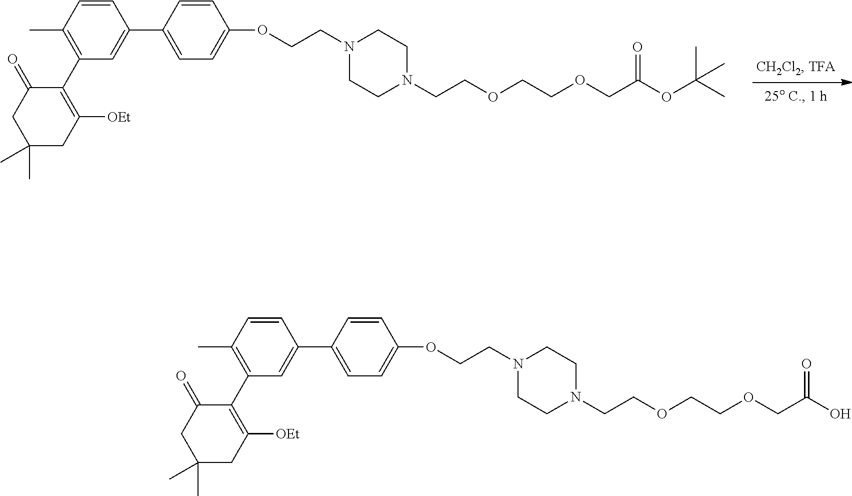

A mixture of tert-butyl 2-[2-[2-[4-[2-[4-[3-(2-ethoxy-4,4-dimethyl-6-oxo-cyclohexen-1-yl)-4-methyl-phenyl]phenoxy]ethyl]piperazin-1-yl]ethoxy]ethoxy]acetate (317 mg, 476.79 μmol) in TFA (5 mL) and CH₂Cl₂ (5 mL) was degassed and purged with N₂, and then the mixture was stirred at 25° C. for 1 hour under N₂ atmosphere. The reaction mixture was concentrated under reduced pressure to afford the crude 2-[2-[2-[4-[2-[4-[3-(2-ethoxy-4,4-dimethyl-6-oxo-cyclohexen-1-yl)-4-methyl-phenyl]phenoxy]ethyl]-piperazin-1-yl]ethoxy]ethoxy]acetic acid (670 mg, TFA salt) as a brown oil, which was used without further purification. LCMS: RT=0.829 min, m/z 609.3 [M+H]⁺.

### E. Step 5

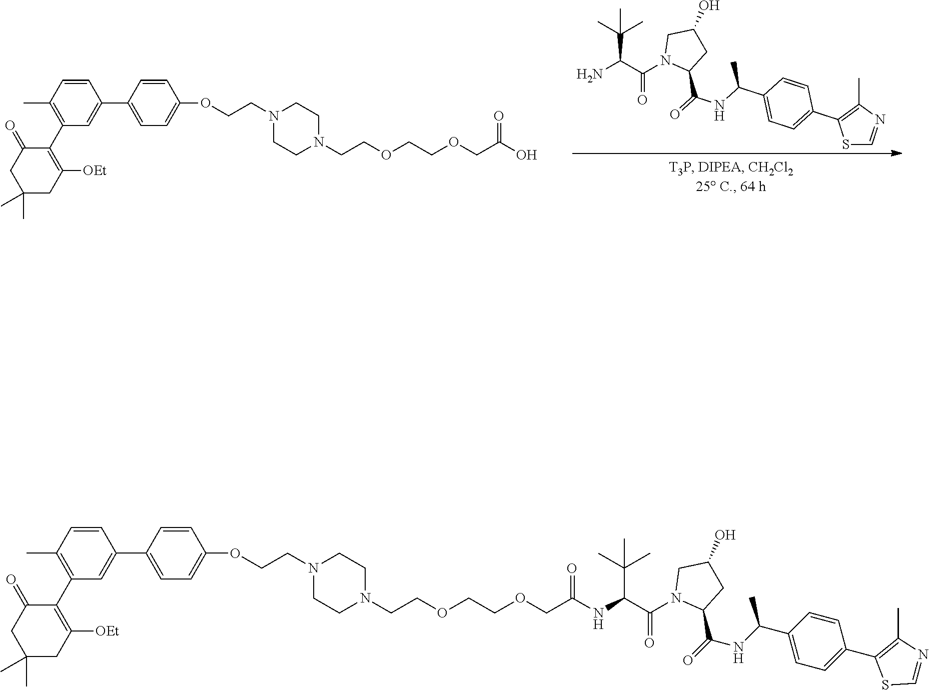 [SMILES: CCOC1=C(c2cc(-c3ccc(OCCN4CCN(CCOCCOCC(=O)O)CC4)cc3)ccc2C)C(=O)CC(C)(C)C1 ; Cc1ncsc1-c1ccc([C@H](C)NC(=O)[C@@H]2C[C@@H](O)CN2C(=O)[C@@H](N)C(C)(C)C)cc1 ; CCOC1=C(c2cc(-c3ccc(OCCN4CCN(CCOCCOCC(=O)N[C@H](C(=O)N5C[C@H](O)C[C@H]5C(=O)N[C@@H](C)c5ccc(-c6scnc6C)cc5)C(C)(C)C)CC4)cc3)ccc2C)C(=O)CC(C)(C)C1]

To a solution of 2-[2-[2-[4-[2-[4-[3-(2-ethoxy-4,4-dimethyl-6-oxo-cyclohexen-1-yl)-4-methyl-phenyl]phenoxy]ethyl]piperazin-1-yl]ethoxy]ethoxy]acetic acid (600 mg, crude, TFA salt), (2S,4R)-1-[(2S)-2-amino-3,3-dimethyl-butanoyl]-4-hydroxy-N-[(1S)-1-[4-(4-methylthiazol-5-yl)-phenyl]ethyl]pyrrolidine-2-carboxamide (160.02 mg, 332.64 μmol, HCl salt) and DIPEA (286.60 mg, 2.22 mmol, 386.26 μL) in CH₂Cl₂ (10 mL) was added T₃P (211.68 mg, 332.64 μmol, 197.83 μL, 50% purity). The mixture was stirred at 25° C. under N₂ for 64 hours. The reaction mixture was concentrated under reduced pressure. The residue was purified by column chromatography (SiO₂, CH₂Cl₂/MeOH=50/1 to 5/1) to afford (2S,4R)-1-[(2S)-2-[[2-[2-[2-[4-[2-[4-[3-(2-ethoxy-4,4-dimethyl-6-oxo-cyclohexen-1-yl)-4-methyl-phenyl]phenoxy]ethyl]piperazin-1-yl]ethoxy]ethoxy]acetyl]amino]-3,3-dimethyl-butanoyl]-4-hydroxy-N-[(1S)-1-[4-(4-methylthiazol-5-yl)-phenyl]ethyl]pyrrolidine-2-carboxamide (180 mg, 126.92 μmol, 57.23% yield, 73% purity) as a yellow oil. LCMS: RT=0.897 min, m/z 1058.2 [M+Na]⁺.

### F. Step 6

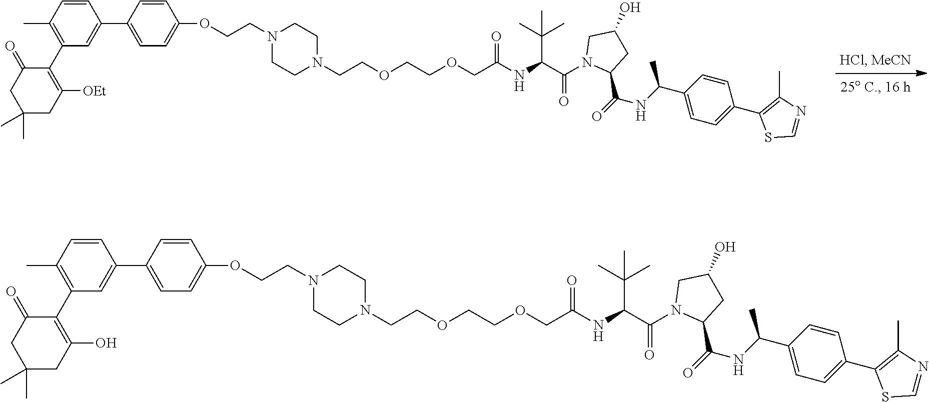 [SMILES: CCOC1=C(c2cc(-c3ccc(OCCN4CCN(CCOCCOCC(=O)N[C@H](C(=O)N5C[C@H](O)C[C@H]5C(=O)N[C@@H](C)c5ccc(-c6scnc6C)cc5)C(C)(C)C)CC4)cc3)ccc2C)C(=O)CC(C)(C)C1 ; Cc1ccc(-c2ccc(OCCN3CCN(CCOCCOCC(=O)N[C@H](C(=O)N4C[C@H](O)C[C@H]4C(=O)N[C@@H](C)c4ccc(-c5scnc5C)cc4)C(C)(C)C)CC3)cc2)cc1C1=C(O)CC(C)(C)CC1=O]

A mixture of (2S,4R)-1-[(2S)-2-[[2-[2-[2-[4-[2-[4-[3-(2-ethoxy-4,4-dimethyl-6-oxo-cyclohexen-1-yl)-4-methyl-phenyl]phenoxy]ethyl]piperazin-1-yl]ethoxy]ethoxy]acetyl]amino]-3,3-dimethyl-butanoyl]-4-hydroxy-N-[(1S)-1-[4-(4-methylthiazol-5-yl)phenyl]ethyl]pyrrolidine-2-carboxamide (180 mg, 126.92 μmol, 73% purity) and HCl (2 M, 0.3 mL) in MeCN (1.5 mL) and was degassed and purged with N₂, and stirred at 25° C. for 16 hours under N₂ atmosphere. The pH was adjusted to 6 by addition of Et₃N. The mixture was purified by prep-HPLC (column: 3_Phenomenex Luna C18 75*30 mm*3 μm; mobile phase: [water(0.05% HCl)-ACN]; B %: 23%-43%, 6.5 min) to afford (2S,4R)-4-hydroxy-1-[(2S)-2-[[2-[2-[2-[4-[2-[4-[3-(2-hydroxy-4,4-dimethyl-6-oxo-cyclohexen-1-yl)-4-methyl-phenyl]phenoxy]ethyl]piperazin-1-yl]ethoxy]-ethoxy]acetyl]amino]-3,3-dimethyl-butanoyl]-N-[(1S)-1-[4-(4-methylthiazol-5-yl)phenyl]ethyl]-pyrrolidine-2-carboxamide (43.9 mg, 41.77 μmol, 24.02% yield, 99.3% purity, HCl salt) as an off-white solid. HNMR: DMSO-d₆+D₂O, 400 MHz. δ 9.02-8.94 (m, 1H), 7.56-7.47 (m, 2H), 7.45-7.38 (m, 2H), 7.38-7.30 (m, 3H), 7.23-7.17 (m, 1H), 7.10-6.99 (m, 3H), 4.86 (q, J=7.2 Hz, 1H), 4.58-4.48 (m, 1H), 4.44-4.32 (m, 3H), 4.31-4.25 (m, 1H), 4.05-3.89 (m, 3H), 3.73-3.54 (m, 19H), 3.46-3.40 (m, 2H), 2.43-2.41 (m, 3H), 2.33-2.31 (m, 4H), 2.11-2.04 (m, 4H), 1.82-1.68 (m, 1H), 1.35 (d, J=7.0 Hz, 3H), 1.12-1.04 (m, 6H), 0.94-0.84 (m, 9H). LCMS: RT=2.132 min, m/z 1008.4 [M+H]⁺.

### Example A-40: Synthesis of (2S,4R)-4-hydroxy-1-[(2S)-2-[[2-[2-[4-[2-[4-[3-(2-hydroxy-4,4-dimethyl-6-oxo-cyclohexen-1-yl)-4-methyl-phenyl]phenoxy]ethyl]piperazin-1-yl]ethoxy]acetyl]amino]-3,3-dimethyl-butanoyl]-N-[(1S)-1-[4-(4-methylthiazol-5-yl)phenyl]ethyl]pyrrolidine-2-carboxamide

The compound of Example A-40 was prepared using general procedures described in Example A-39.

HNMR: DMSO-d6, 400 MHz. δ 8.98 (s, 1H), 8.44 (d, J=7.6 Hz, 1H), 8.16 (s, 1H), 7.52-7.46 (m, 2H), 7.45-7.40 (m, 2H), 7.39-7.31 (m, 4H), 7.19 (d, J=8.0 Hz, 1H), 7.09 (d, J=2.0 Hz, 1H), 7.01-6.96 (m, 2H), 5.25-5.01 (m, 1H), 4.95-4.84 (m, 1H), 4.54 (d, J=9.6 Hz, 1H), 4.48-4.39 (m, 1H), 4.31-4.20 (m, 1H), 4.09 (t, J=5.6 Hz, 2H), 3.97-3.89 (m, 2H), 3.63-3.48 (m, 8H), 2.72-2.67 (m, 2H), 2.57-2.51 (m, 4H), 2.45 (s, 3H), 2.44-2.26 (m, 6H), 2.09-1.99 (m, 4H), 1.82-1.72 (m, 1H), 1.49-1.32 (m, 3H), 1.14-1.05 (m, 6H), 0.96-0.90 (m, 9H). LCMS: RT=2.027 min, m/z 963.5 [M+H]⁺.

### Example A-41: Synthesis of (2S,4R)-1-((S)-2-(tert-butyl)-17-(4-(2-((6″-hydroxy-4′,4″,4″-trimethyl-2″-oxo-2″,3″,4″,5″-tetrahydro-[1,1′:3′,1″-terphenyl]-4-yl)oxy)ethyl)piperazin-1-yl)-4-oxo-6,9,12,15-tetraoxa-3-azaheptadecanoyl)-4-hydroxy-N—((S)-1-(4-(4-methylthiazol-5-yl)phenyl)ethyl)pyrrolidine-2-carboxamide

The compound of Example A-41 was prepared using general procedures described in Example A-39.

HNMR: DMSO-d6, 400 MHz. δ 9.06-8.91 (m, 1H), 8.50-8.37 (m, 1H), 7.50-7.32 (m, 8H), 7.22-7.15 (m, 1H), 7.08 (d, J=1.6 Hz, 1H), 7.01-6.94 (m, 2H), 5.24-5.02 (m, 1H), 4.95-4.87 (m, 1H), 4.54 (d, J=9.6 Hz, 1H), 4.48-4.38 (m, 1H), 4.34-4.24 (m, 1H), 4.11-4.04 (m, 2H), 3.98-3.90 (m, 2H), 3.62-3.48 (m, 18H), 2.71-2.64 (m, 2H), 2.48-2.39 (m, 11H), 2.38-2.28 (m, 4H), 2.04 (s, 4H), 1.82-1.72 (m, 1H), 1.50-1.25 (m, 3H), 1.10 (s, 6H), 0.94 (s, 9H). LCMS: RT=2.030 min, m/z=1096.3 [M+H]⁺.

### Example A-42: Synthesis of (2S)-2-[[2-[3-(4-hydroxyphenyl)propanoylamino]-2-methyl-propanoyl]amino]-3-methyl-N-[(1S)-2-methyl-1-(pyrrolidine-1-carbonyl)propyl]butanamide

### A. Step 1

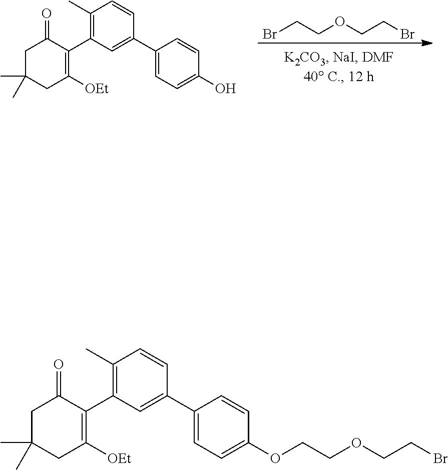 [SMILES: CCOC1=C(c2cc(-c3ccc(O)cc3)ccc2C)C(=O)CC(C)(C)C1 ; BrCCOCCBr ; CCOC1=C(c2cc(-c3ccc(OCCOCCBr)cc3)ccc2C)C(=O)CC(C)(C)C1]

To a mixture of 3-ethoxy-2-[5-(4-hydroxyphenyl)-2-methyl-phenyl]-5,5-dimethyl-cyclohex-2-en-1-one (Int 1) (600 mg, 1.71 mmol) in DMF (10 mL) were added 1-bromo-2-(2-bromoethoxy)ethane (595.58 mg, 2.57 mmol, 321.94 μL), K₂CO₃ (709.86 mg, 5.14 mmol) and NaI (256.63 mg, 1.71 mmol). The mixture was stirred at 40° C. for 12 hours. The reaction was partitioned between EtOAc (20 mL) and water (20 mL). The aqueous phase was extracted with EtOAc (10 mL×3). The combined extracts were washed with brine (20 mL), dried over Na₂SO₄, filtered, and concentrated under vacuum. The residue was purified by flash silica gel chromatography (ISCO®; 20 g SepaFlash® Silica Flash Column, Eluent of 0-20% EtOAc:PE @50 mL/min) to afford 2-[5-[4-[2-(2-bromoethoxy)ethoxy]phenyl]-2-methyl-phenyl]-3-ethoxy-5,5-dimethyl-cyclohex-2-en-1-one (570 mg, 1.14 mmol, 66.39% yield) as a colorless oil. LCMS: RT=1.064 min, m/z 501.4 [M+H]⁺.

### B. Step 2

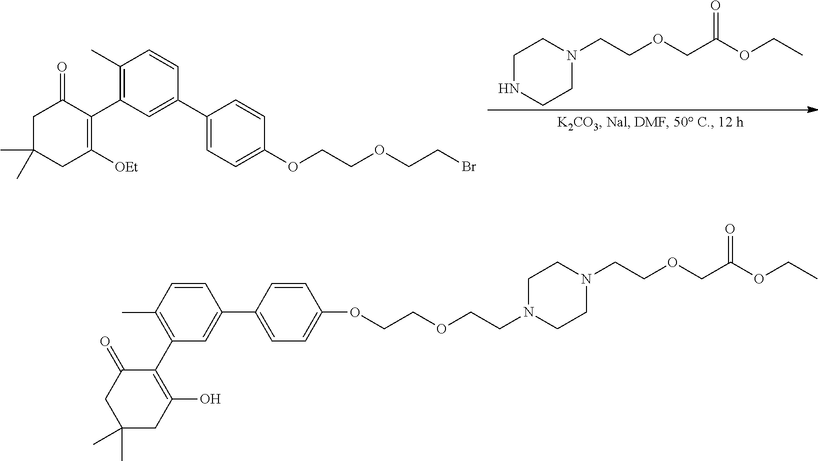 [SMILES: CCOC1=C(c2cc(-c3ccc(OCCOCCBr)cc3)ccc2C)C(=O)CC(C)(C)C1 ; CCOC(=O)COCCN1CCNCC1 ; CCOC(=O)COCCN1CCN(CCOCCOc2ccc(-c3ccc(C)c(C4=C(O)CC(C)(C)CC4=O)c3)cc2)CC1]

To a stirred mixture of 2-[5-[4-[2-(2-bromoethoxy)ethoxy]phenyl]-2-methyl-phenyl]-3-ethoxy-5,5-dimethyl-cyclohex-2-en-1-one (180 mg, 358.96 μmol) and ethyl 2-(2-piperazin-1-ylethoxy)acetate (237.13 mg, 717.92 μmol, TFA) in DMF (2 mL) were added K₂CO₃ (198.45 mg, 1.44 mmol, 122.46 μL) and NaI (53.80 mg, 358.96 μmol) at room temperature (25° C.). The mixture was stirred at 50° C. for 12 hours. The mixture was diluted with EtOAc (50 mL), washed with water (50 mL*2) and brine (50 mL*2). The organic phase was dried over anhydrous Na₂SO₄, filtered, and concentrated in vacuo. The residue was purified by column chromatography (SiO₂, CH₂Cl₂:MeOH=1:0 to 10:1) to afford ethyl 2-[2-[4-[2-[2-[4-[3-(2-ethoxy-4,4-dimethyl-6-oxo-cyclohexen-1-yl)-4-methyl-phenyl]phenoxy]ethoxy]ethyl]piperazin-1-yl]ethoxy]acetate (0.2 g, 314.06 μmol, 87.49% yield) as a yellow oil. HNMR: CDCl₃, 400 MHz. δ 7.49 (d, J=8.8 Hz, 2H), 7.37 (dd, J=8.0, 2.0 Hz, 1H), 7.24 (d, J=8.0 Hz, 1H), 7.17 (d, J=2.0 Hz, 1H), 6.94 (d, J=8.8 Hz, 2H), 4.16-4.14 (m, 2H), 4.10 (s, 2H), 3.90-3.83 (m, 4H), 3.75-3.69 (m, 10H), 2.67-2.41 (m, 13H), 2.40 (s, 2H), 2.14 (s, 3H), 1.21 (s, 6H), 1.17 (t, J=7.2 Hz, 3H).

### C. Step 3

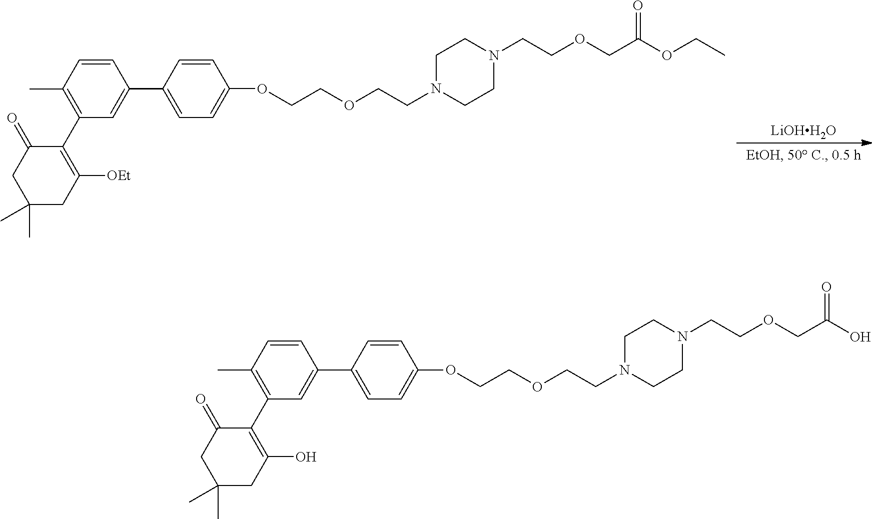

To a stirred solution of ethyl 2-[2-[4-[2-[2-[4-[3-(2-ethoxy-4,4-dimethyl-6-oxo-cyclohexen-1-yl)-4-methylphenyl]phenoxy]ethoxy]ethyl]piperazin-1-yl]ethoxy]acetate (180 mg, 282.66 μmol) in EtOH (1 mL) and H₂O (0.5 mL) was added LiOH·H₂O (59.30 mg, 1.41 mmol) at room temperature (25° C.). The mixture was stirred at 50° C. for 0.5 hours. The mixture was concentrated in vacuo. The residue was diluted with 2N HCl (10 mL) and stirred at 35° C. for 1 hour. The mixture was concentrated in vacuo to afford 2-[2-[4-[2-[2-[4-[3-(2-hydroxy-4,4-dimethyl-6-oxo-cyclohexen-1-yl)-4-methyl-phenyl]phenoxy]ethoxy]ethyl]piperazin-1-yl]ethoxy]acetic acid (0.17 g, crude) as a white solid, which was used without further purification. LCMS: RT=0.693 min, m/z 581.2 [M+H]⁺.

### D. Step 4

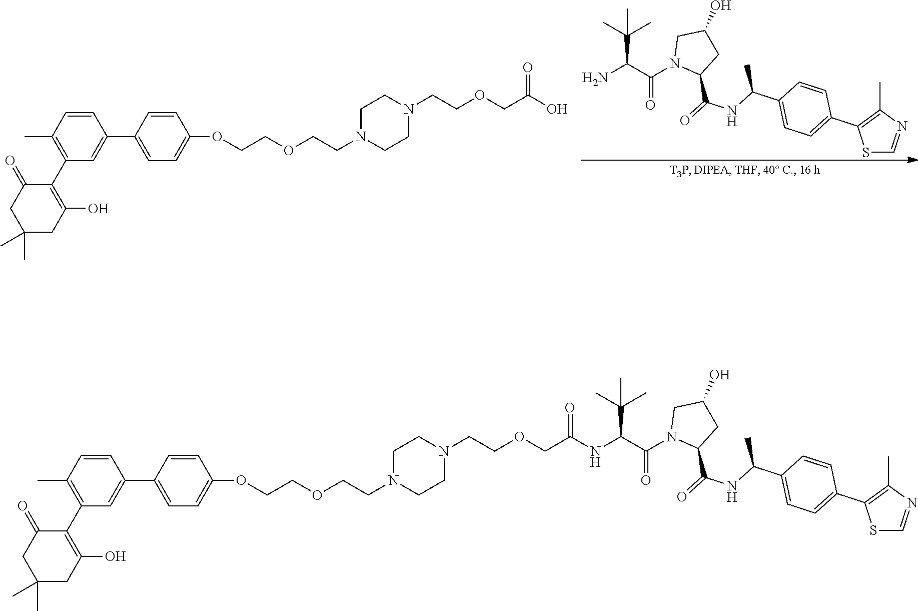 [SMILES: Cc1ccc(-c2ccc(OCCOCCN3CCN(CCOCC(=O)O)CC3)cc2)cc1C1=C(O)CC(C)(C)CC1=O ; Cc1ncsc1-c1ccc([C@H](C)NC(=O)[C@@H]2C[C@@H](O)CN2C(=O)[C@@H](N)C(C)(C)C)cc1 ; Cc1ccc(-c2ccc(OCCOCCN3CCN(CCOCC(=O)N[C@H](C(=O)N4C[C@H](O)C[C@H]4C(=O)N[C@@H](C)c4ccc(-c5scnc5C)cc4)C(C)(C)C)CC3)cc2)cc1C1=C(O)CC(C)(C)CC1=O]

To a stirred mixture of 2-[2-[4-[2-[2-[4-[3-(2-hydroxy-4,4-dimethyl-6-oxo-cyclohexen-1-yl)-4-methylphenyl]phenoxy]ethoxy]ethyl]piperazin-1-yl]ethoxy]acetic acid (170 mg, 292.75 μmol) and (2S,4R)-1-[(2S)-2-amino-3,3-dimethyl-butanoyl]-4-hydroxy-N-[(1S)-1-[4-(4-methylthiazol-5-yl)phenyl]ethyl]pyrrolidine-2-carboxamide (201.55 mg, 418.98 μmol, HCl) in THF (2 mL) was added T₃P (533.24 mg, 837.95 μmol, 498.36 μL, 50% in DMF) and DIPEA (288.73 mg, 2.23 mmol, 389.12 μL) at room temperature (25° C.). The mixture was stirred at 40° C. for 16 hours. The mixture was concentrated in vacuo and the residue was purified by prep-HPLC (column: Phenomenex luna C18 150*25 mm*10 μm; mobile phase: [water(0.225% FA)-ACN]; B %: 19%-49%, 10 min) to afford (2S,4R)-4-hydroxy-1-[(2S)-2-[[2-[2-[4-[2-[2-[4-[3-(2-hydroxy-4,4-dimethyl-6-oxo-cyclohexen-1-yl)-4-methylphenyl]phenoxy]ethoxy]-ethyl]piperazin-1-yl]ethoxy]acetyl]amino]-3,3-dimethyl-butanoyl]-N-[(1S)-1-[4-(4-methylthiazol-5-yl)phenyl]ethyl]pyrrolidine-2-carboxamide (29.56 mg, 25.51 μmol, 8.71% yield, 90.9% purity, formic acid salt) as an off-white solid. HNMR: DMSO-d₆, 400 MHz. δ 8.99 (s, 1H), 8.46 (d, J=7.6 Hz, 1H), 8.20 (s, 1H), 7.51-7.50 (m, 2H), 7.49-7.45 (m, 2H), 7.43-7.36 (m, 4H), 7.20 (d, J=8.0 Hz, 1H), 7.09 (d, J=1.8 Hz, 1H), 7.00-6.98 (m, 2H), 4.92-4.91 (m, 1H), 4.54 (d, J=9.6 Hz, 1H), 4.44 (t, J=8.4 Hz, 1H), 4.28 (brs, 1H), 4.12-4.10 (m, 2H), 3.95-3.94 (m, 2H), 3.74-3.71 (m, 2H), 3.59-3.56 (m, 8H), 2.47-2.32 (m, 17H), 2.04-2.03 (m, 4H), 1.77-1.74 (m, 1H), 1.38 (d, J=7.2 Hz, 3H), 1.11 (s, 6H), 0.94 (s, 9H). LCMS: RT=2.050 min, m/z 1007.5 [M+H]⁺.

### Example A-43: Synthesis of (2S,4R)-4-hydroxy-1-[(2S)-2-[[2-[2-[2-[4-[2-[2-[4-[3-(2-hydroxy-4,4-dimethyl-6-oxo-cyclohexen-1-yl)-4-methyl-phenyl]phenoxy]ethoxy]ethyl]piperazin-1-yl]ethoxy]ethoxy]acetyl]amino]-3,3-dimethyl-butanoyl]-N-[(1S)-1-[4-(4-methylthiazol-5-yl)phenyl]ethyl]pyrrolidine-2-carboxamide

The compound of Example A-43 was prepared using general procedures described in Example A-42.

HNMR: DMSO-d6, 400 MHz. δ 8.93-8.89 (m, 1H), 8.51-8.45 (m, 1H), 7.46-7.33 (m, 7H), 7.30-7.24 (m, 1H), 7.16-7.12 (m, 1H), 7.05 (s, 1H), 6.97-6.93 (m, 2H), 4.88-4.83 (m, 2H), 4.52-4.39 (m, 10H), 3.58-3.52 (m, 9H), 2.42-2.39 (m, 8H), 2.36-2.18 (m, 8H), 2.09-1.99 (m, 5H), 1.79-1.73 (m, 1H), 1.47-1.21 (m, 4H), 1.05 (d, J=4.4 Hz, 6H), 0.90 (s, 9H). LCMS: RT=2.024 min, m/z 1051.6 [M+H]⁺.

### Example A-44: Synthesis of (2S,4R)-4-hydroxy-1-[(2S)-2-[[2-[2-[4-[2-[2-[2-[2-[4-[3-(2-hydroxy-4,4-dimethyl-6-oxo-cyclohexen-1-yl)-4-methyl-phenyl]phenoxy]ethoxy]ethoxy]ethoxy]ethyl]piperazin-1-yl]ethoxy]acetyl]amino]-3,3-dimethyl-butanoyl]-N-[(1S)-1-[4-(4-methylthiazol-5-yl)phenyl]ethyl]pyrrolidine-2-carboxamide

The compound of Example A-44 was prepared using general procedures described in Example A-42.

HNMR: DMSO-d6, 400 MHz. S 9.02-8.94 (m, 1H), 8.45 (d, J=8.0 Hz, 1H), 7.51-7.46 (m, 2H), 7.45-7.41 (m, 2H), 7.39-7.29 (m, 4H), 7.19-7.14 (m, 1H), 7.13-7.07 (m, 1H), 6.98 (d, J=8.8 Hz, 2H), 4.97-4.84 (m, 1H), 4.56-4.51 (m, 1H), 4.48-4.39 (m, 1H), 4.32-4.21 (m, 1H), 4.14-4.06 (m, 2H), 3.96-3.86 (m, 2H), 3.78-3.73 (m, 2H), 3.62-3.49 (m, 16H), 2.46-2.22 (m, 17H), 2.10-1.97 (m, 4H), 1.82-1.70 (m, 1H), 1.45-1.29 (m, 3H), 1.09 (d, J=3.6 Hz, 6H), 0.96-0.90 (m, 9H). LCMS: RT=2.110 min, m/z=1095.6 [M+H]⁺.

### Example b-1. Synthesis of (2S,4R)-1-((S)-2-(8-(2-((2-(3,4-dichlorophenyl)acetamido)methyl)-4-(6,7-dihydro-5H-pyrrolo[1,2-a]imidazol-2-yl)phenoxy)octanamido)-3,3-dimethylbutanoyl)-4-hydroxy-N-(4-(4-methylthiazol-5-yl)benzyl)pyrrolidine-2-carboxamide

### A. Step 1

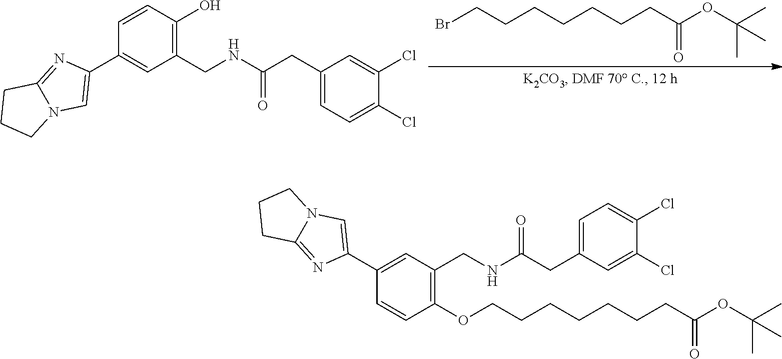 [SMILES: O=C(Cc1ccc(Cl)c(Cl)c1)NCc1cc(-c2cn3c(n2)CCC3)ccc1O ; CC(C)(C)OC(=O)CCCCCCCBr ; CC(C)(C)OC(=O)CCCCCCCOc1ccc(-c2cn3c(n2)CCC3)cc1CNC(=O)Cc1ccc(Cl)c(Cl)c1]

To a solution of 2-(3,4-dichlorophenyl)-N-(5-(6,7-dihydro-5H-pyrrolo[1,2-a]imidazol-2-yl)-2-hydroxybenzyl)acetamide (150 mg, 360.32 μmol) and tert-butyl 8-bromooctanoate (150.91 mg, 540.48 μmol) in DMF (2 mL) was added K₂CO₃ (99.60 mg, 720.63 μmol). The mixture was stirred at 70° C. for 12 h. To the mixture were added ethyl acetate (50 mL) and water (15 mL), and the layers were separated. The aqueous phase was extracted with ethyl acetate (15 mL×3). The combined organic layers were washed with brine (20 mL), dried over Na₂SO₄, filtered, and concentrated in vacuo. The residue was purified by prep-TLC on silica (CH₂Cl₂/MeOH=10/1) to give tert-butyl 8-(2-((2-(3,4-dichlorophenyl)acetamido)methyl)-4-(6,7-dihydro-5H-pyrrolo[1,2-a]imidazol-2-yl)phenoxy)octanoate (150 mg, 244.06 μmol, 67.73% yield) as a yellow oil. LCMS: RT=0.588 min, m/z 614.3 [M+H]⁺.

### B. Step 2

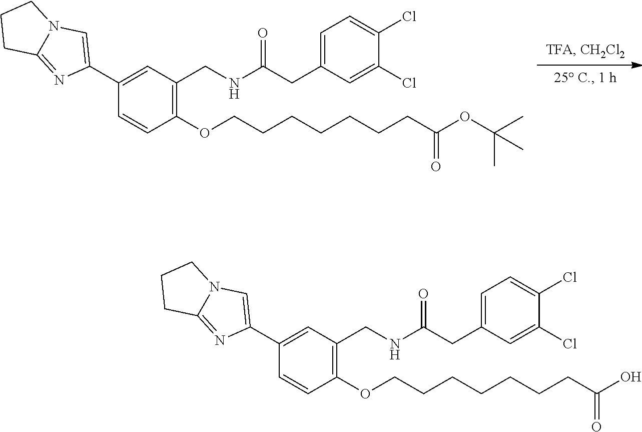 [SMILES: CC(C)(C)OC(=O)CCCCCCCOc1ccc(-c2cn3c(n2)CCC3)cc1CNC(=O)Cc1ccc(Cl)c(Cl)c1 ; O=C(O)CCCCCCCOc1ccc(-c2cn3c(n2)CCC3)cc1CNC(=O)Cc1ccc(Cl)c(Cl)c1]

To a solution of tert-butyl 8-(2-((2-(3,4-dichlorophenyl)acetamido)methyl)-4-(6,7-dihydro-5H-pyrrolo[1,2-a]imidazol-2-yl)phenoxy)octanoate (150 mg, 244.06 μmol) in CH₂Cl₂ (2 mL) was added TFA (26.92 mmol, 2 mL). The mixture was stirred at 25° C. for 1 h. The mixture was concentrated in vacuo to give 8-(2-((2-(3,4-dichlorophenyl)acetamido)methyl)-4-(6,7-dihydro-5H-pyrrolo[1,2-a]imidazol-2-yl)phenoxy)octanoic acid (130 mg, 232.77 μmol, 95.37% yield) as a yellow oil. LCMS: RT=0.507 min, m/z 558.2 [M+H]⁺.

### C. Step 3

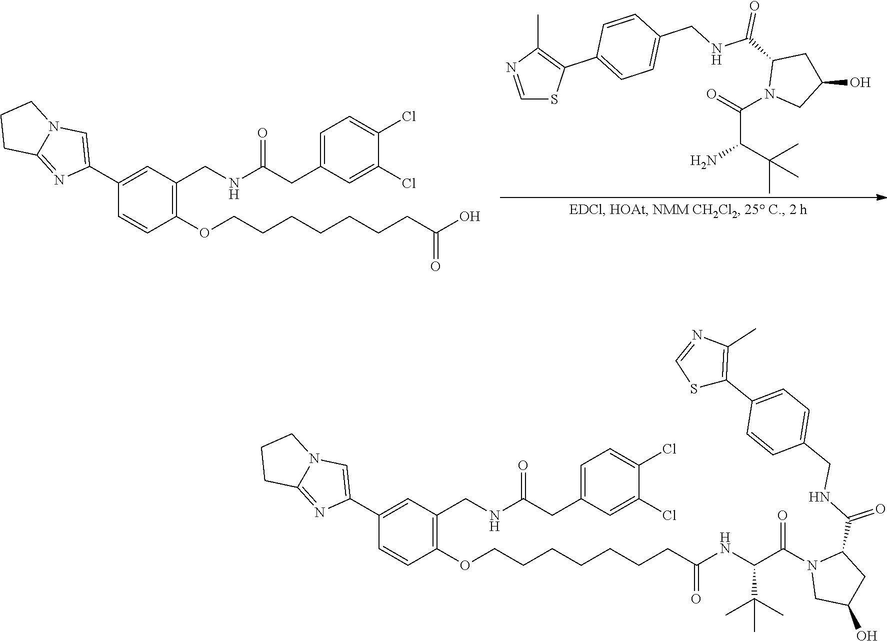 [SMILES: O=C(O)CCCCCCCOc1ccc(-c2cn3c(n2)CCC3)cc1CNC(=O)Cc1ccc(Cl)c(Cl)c1 ; Cc1ncsc1-c1ccc(CNC(=O)[C@@H]2C[C@@H](O)CN2C(=O)[C@@H](N)C(C)(C)C)cc1 ; Cc1ncsc1-c1ccc(CNC(=O)[C@@H]2C[C@@H](O)CN2C(=O)[C@@H](NC(=O)CCCCCCCOc2ccc(-c3cn4c(n3)CCC4)cc2CNC(=O)Cc2ccc(Cl)c(Cl)c2)C(C)(C)C)cc1]

To a solution of 8-(2-((2-(3,4-dichlorophenyl)acetamido)methyl)-4-(6,7-dihydro-5H-pyrrolo[1,2-a]imidazol-2-yl)phenoxy)octanoic acid (100 mg, 179.05 μmol) and (2S,4R)-1-[(2S)-2-amino-3,3-dimethyl-butanoyl]-4-hydroxy-N-[[4-(4-methylthiazol-5-yl)phenyl]methyl]pyrrolidine-2-carboxamide (77.09 mg, 179.05 μmol) in CH₂Cl₂ (2 mL) was added EDCI (51.49 mg, 268.58 μmol), NMM (54.33 mg, 537.16 μmol) and HOAt (36.56 mg, 268.58 μmol). The mixture was stirred at 25° C. for 2 h. The mixture was concentrated in vacuo. The residue was purified by prep-HPLC (column: Phenomenex luna C18 150*25 mm*10 um; mobile phase: [water(FA)-ACN]; gradient: 26%-56% B over 10 min) to give (2S,4R)-1-((S)-2-(8-(2-((2-(3,4-dichlorophenyl)acetamido)methyl)-4-(6,7-dihydro-5H-pyrrolo[1,2-a]imidazol-2-yl)phenoxy)octanamido)-3,3-dimethylbutanoyl)-4-hydroxy-N-(4-(4-methylthiazol-5-yl)benzyl)pyrrolidine-2-carboxamide (67.19 mg, 66.41 μmol, 37.09% yield, 95.98% purity) as a yellow solid. ¹H NMR: CDCl₃, 400 MHz δ 8.68 (s, 1H), 7.62-7.41 (m, 3H), 7.39-7.30 (m, 6H), 7.17 (br d, J=8.0 Hz, 1H), 7.03 (s, 1H), 6.83 (d, J=8.4 Hz, 2H), 6.21 (d, J=8.8 Hz, 1H), 4.70 (t, J=8.0 Hz, 1H), 4.59-4.42 (m, 5H), 4.38-4.30 (m, 1H), 4.12-4.02 (m, 3H), 3.95-3.86 (m, 2H), 3.57 (s, 3H), 3.08-3.02 (m, 2H), 2.72-2.64 (m, 2H), 2.50-2.44 (m, 4H), 2.25-2.07 (m, 3H), 1.75-1.53 (m, 4H), 1.44-1.28 (m, 6H), 0.93 (s, 9H). LCMS: RT=1.727 min, m/z 970.4 [M+H]⁺.

### Example B-2. Synthesis of (2S,4R)-1-((S)-2-(9-(2-((2-(3,4-dichlorophenyl)acetamido)methyl)-4-(6,7-dihydro-5H-pyrrolo[1,2-a]imidazol-2-yl)phenoxy)nonanamido)-3,3-dimethylbutanoyl)-4-hydroxy-N-(4-(4-methylthiazol-5-yl)benzyl)pyrrolidine-2-carboxamide

¹H NMR: METHANOL-d₄, 400 MHz. δ 8.88 (s, 1H), 7.88-7.80 (m, 1H), 7.60-7.40 (m, 8H), 7.30-7.24 (m, 1H), 7.20 (s, 1H), 6.97 (d, J=8.8 Hz, 1H), 4.68-4.64 (m, 1H), 4.62-4.47 (m, 3H), 4.43-4.34 (m, 3H), 4.14-4.08 (m, 2H), 4.02-3.95 (m, 2H), 3.95-3.89 (m, 1H), 3.85-3.78 (m, 1H), 3.57 (s, 2H), 3.00-2.92 (m, 2H), 2.75-2.64 (m, 2H), 2.49 (s, 3H), 2.36-2.19 (m, 3H), 2.15-2.04 (m, 1H), 1.76-1.70 (m, 2H), 1.66-1.58 (m, 2H), 1.52-1.43 (m, 2H), 1.41-1.34 (m, 6H), 1.06-1.01 (s, 9H). LCMS: RT=1.791 min, m/z 984.4 [M+H]⁺.

### Example B-3. Synthesis of (2S,4R)-1-[(2S)-2-[10-[2-[[[2-(3,4-dichlorophenyl)acetyl]amino]methyl]-4-(6,7-dihydro-5H-pyrrolo[1,2-a]imidazol-2-yl)phenoxy]decanoylamino]-3,3-dimethyl-butanoyl]-4-hydroxy-N-[[4-(4-methylthiazol-5-yl)phenyl]methyl]pyrrolidine-2-carboxamide

The title compound was prepared using general procedures described for (2S,4R)-1-((S)-2-(8-(2-((2-(3,4-dichlorophenyl)acetamido)methyl)-4-(6,7-dihydro-5H-pyrrolo[1,2-a]imidazol-2-yl)phenoxy)octanamido)-3,3-dimethylbutanoyl)-4-hydroxy-N-(4-(4-methylthiazol-5-yl)benzyl)pyrrolidine-2-carboxamide. ¹H NMR: 1H NMR (400 MHz, MeOD-d₄) δ 8.85-8.88 (m, 1H), 8.66 (t, J=6.0 Hz, 1H), 8.39 (t, J=5.2 Hz, 1H), 7.86-7.48 (m, 1H), 7.54-7.40 (m, 9H), 7.26-7.20 (m, 1H), 7.06 (d, J=8.4 Hz, 1H), 4.66-4.48 (m, 4H), 4.41-4.25 (m, 5H), 4.08-4.01 (m, 2H), 3.93-3.87 (m, 1H), 3.83-3.77 (m, 1H), 3.54 (s, 2H), 3.23-3.17 (m, 2H), 2.83-2.76 (m, 2H), 2.48-2.45 (m, 3H), 2.12-2.03 (m, 1H), 1.79-1.71 (m, 2H), 1.64-1.55 (m, 2H), 1.49-1.42 (m, 2H), 1.38-1.30 (m, 8H), 1.05-1.00 (m, 9H). LCMS: RT=1.842 min, m/z 998.4 [M+H]⁺.

### Example B-4. Synthesis of (2S,4R)-1-((S)-2-(10-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-10-oxodecanamido)-3,3-dimethylbutanoyl)-4-hydroxy-N—((S)-1-(4-(4-methylthiazol-5-yl)phenyl)ethyl)pyrrolidine-2-carboxamide

### A. Step 1

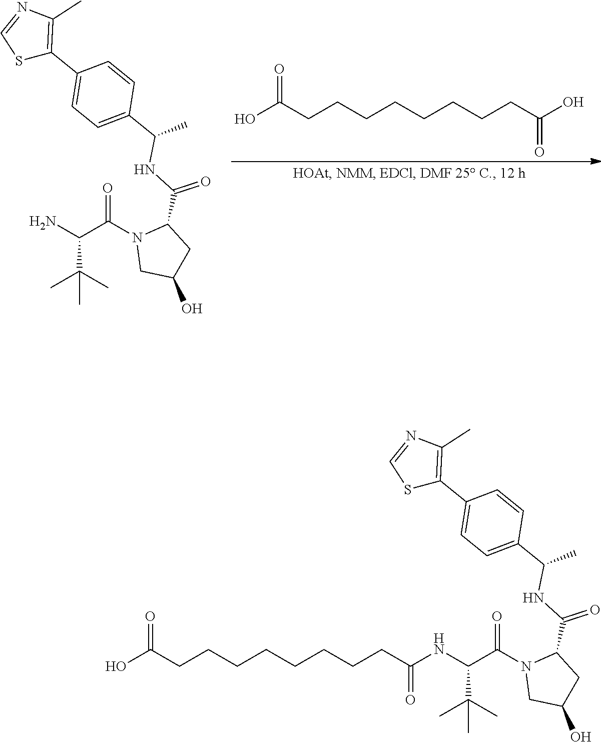 [SMILES: Cc1ncsc1-c1ccc([C@H](C)NC(=O)[C@@H]2C[C@@H](O)CN2C(=O)[C@@H](N)C(C)(C)C)cc1 ; O=C(O)CCCCCCCCC(=O)O ; Cc1ncsc1-c1ccc([C@H](C)NC(=O)[C@@H]2C[C@@H](O)CN2C(=O)[C@@H](NC(=O)CCCCCCCCC(=O)O)C(C)(C)C)cc1]

To a solution of decanedioic acid (409.42 mg, 2.02 mmol) in DMF (3 mL) was added NMM (341.26 mg, 3.37 mmol, 370.94 μL), EDCI (155.23 mg, 809.74 μmol), HOAt (18.37 mg, 134.96 μmol) and (2S,4R)-1-((S)-2-amino-3,3-dimethylbutanoyl)-4-hydroxy-N—((S)-1-(4-(4-methylthiazol-5-yl)phenyl)ethyl)pyrrolidine-2-carboxamide (300 mg, 674.78 μmol). The mixture was stirred at 25° C. for 12 hours. The mixture was diluted with H₂O (10 mL) and extracted with ethyl acetate (5 mL×3). The combined organic layer was washed with brine (5 mL×3), dried over anhydrous Na₂SO₄, filtered, and concentrated in vacuo. The residue was purified by prep-HPLC (column: Phenomenex luna C18 150*25 mm*10 um; mobile phase: [water(FA)-ACN]; gradient: 38%-58% B over 10 min) to give 10-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)amino)-10-oxodecanoic acid (320 mg, 508.89 μmol, 75.42% yield) as a white solid. LCMS: RT=0.523 min, m/z 629.3[M+H]⁺.

### B. Step 2

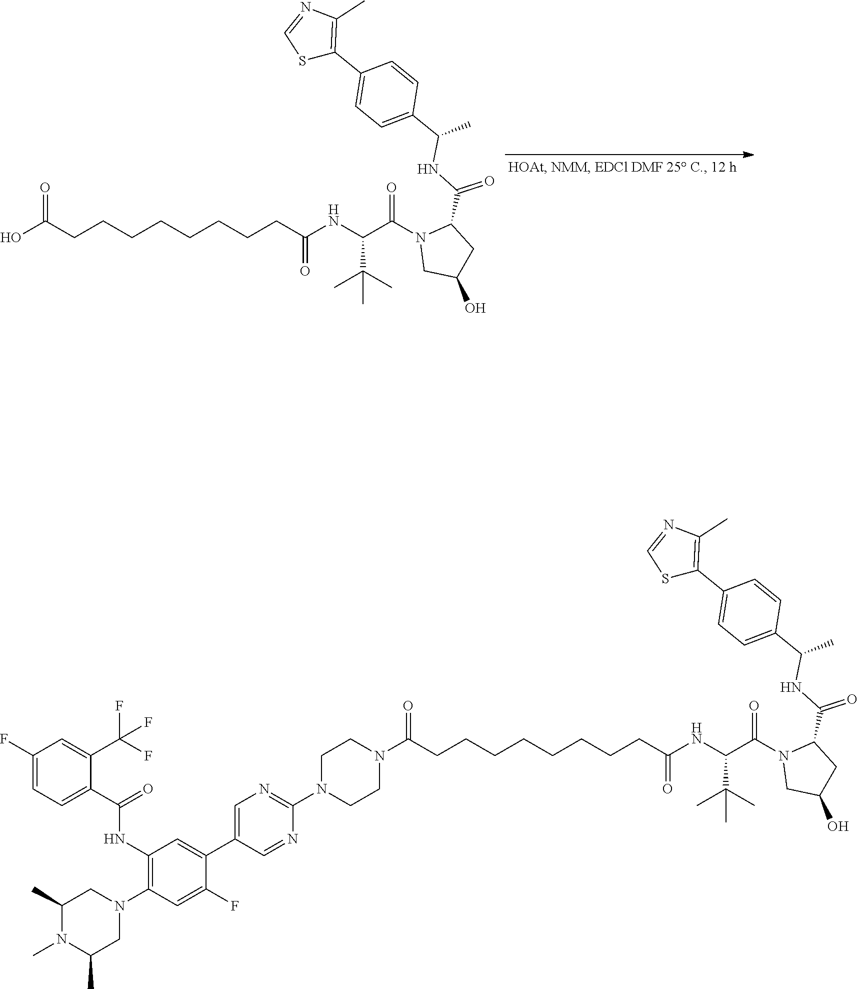 [SMILES: Cc1ncsc1-c1ccc([C@H](C)NC(=O)[C@@H]2C[C@@H](O)CN2C(=O)[C@@H](NC(=O)CCCCCCCCC(=O)O)C(C)(C)C)cc1 ; Cc1ncsc1-c1ccc([C@H](C)NC(=O)[C@@H]2C[C@@H](O)CN2C(=O)[C@@H](NC(=O)CCCCCCCCC(=O)N2CCN(c3ncc(-c4cc(NC(=O)c5ccc(F)cc5C(F)(F)F)c(N5C[C@@H](C)N(C)[C@@H](C)C5)cc4F)cn3)CC2)C(C)(C)C)cc1]

To a solution of 10-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)amino)-10-oxodecanoic acid (150 mg, 238.54 μmol) in DMF (3 mL) was added NMM (100.53 mg, 993.92 mol, 109.27 μL), EDCI (45.73 mg, 238.54 mol), HOAt (5.41 mg, 39.76 μmol) and 4-fluoro-N-(4-fluoro-5-(2-(piperazin-1-yl)pyrimidin-5-yl)-2-((3R,5S)-3,4,5-trimethylpiperazin-1-yl)phenyl)-2-(trifluoromethyl)benzamide (124.45 mg, 198.78 μmol, HCl). The mixture was stirred at 25° C. for 12 hours. The reaction mixture was concentrated under reduced pressure to remove solvent. The residue was purified by prep-HPLC (column: Phenomenex luna C18 150*25 mm*10 um; mobile phase: [water(FA)-ACN]; gradient: 27%-57% B over 10 min) to give (2S,4R)-1-((S)-2-(10-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-10-oxodecanamido)-3,3-dimethylbutanoyl)-4-hydroxy-N—((S)-1-(4-(4-methylthiazol-5-yl)phenyl)ethyl)pyrrolidine-2-carboxamide (99.36 mg, 78.63 μmol, 39.56% yield, 95.68% purity) as a white solid ¹H NMR: CDCl₃, 400 MHz. δ 8.68 (s, 1H), 8.62-8.51 (m, 4H), 7.70-7.64 (m, 1H), 7.53-7.46 (m, 2H), 7.43-7.36 (m, 5H), 7.08-7.01 (m, 1H), 6.19-6.11 (m, 1H), 5.14-5.05 (m, 1H), 4.79-4.71 (m, 1H), 4.57 (d, J=8.8 Hz, 1H), 4.54-4.50 (m, 1H), 4.18-4.11 (m, 1H), 3.95-3.85 (m, 4H), 3.75-3.67 (m, 2H), 3.63-3.55 (m, 3H), 2.89-2.81 (m, 2H), 2.62-2.48 (m, 5H), 2.41-2.35 (m, 4H), 2.24-2.19 (m, 2H), 2.15-2.00 (m, 2H), 1.88-1.78 (m, 3H), 1.70-1.58 (m, 5H), 1.48 (d, J=7.2 Hz, 3H), 1.36-1.28 (m, 8H), 1.22-1.24 (m, 4H), 1.06 (s, 9H). LCMS: RT=1.914 min, m/z 1200.6 [M+H]⁺.

### Example B-5. Synthesis of (2S,4R)-1-((S)-2-(2-(4-(4-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-4-oxobutyl)piperazin-1-yl)acetamido)-3,3-dimethylbutanoyl)-4-hydroxy-N—((S)-1-(4-(4-methylthiazol-5-yl)phenyl)ethyl)pyrrolidine-2-carboxamide

### A. Step 1

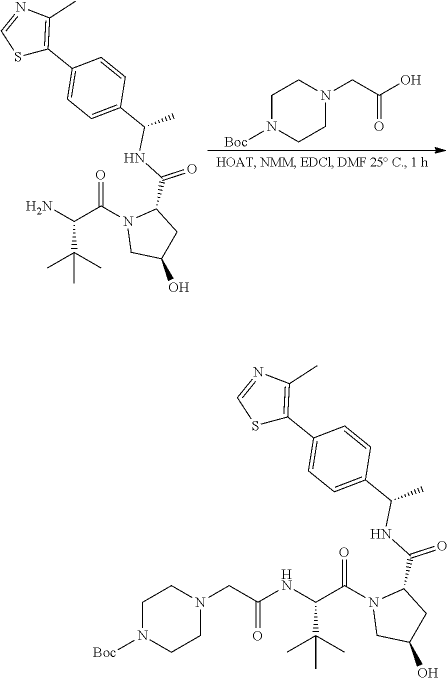 [SMILES: Cc1ncsc1-c1ccc([C@H](C)NC(=O)[C@@H]2C[C@@H](O)CN2C(=O)[C@@H](N)C(C)(C)C)cc1 ; CC(C)(C)OC(=O)N1CCN(CC(=O)O)CC1 ; Cc1ncsc1-c1ccc([C@H](C)NC(=O)[C@@H]2C[C@@H](O)CN2C(=O)[C@@H](NC(=O)CN2CCN(C(=O)OC(C)(C)C)CC2)C(C)(C)C)cc1]

To a solution of 2-(4-(tert-butoxycarbonyl)piperazin-1-yl)acetic acid (321.44 mg, 1.32 mmol) in DMF (5 mL) was added NN (511.89 mg, 5.06 mmol, 556.40 μL), EDCI (232.84 mg, 1.21 mmol), HOAt (27.55 mg, 202.43 μmol) and (2S,4R)-1-((S)-2-amino-3,3-dimethylbutanoyl)-4-hydroxy-N—((S)-1-(4-(4-methylthiazol-5-yl)phenyl)ethyl)pyrrolidine-2-carboxamide (450 mg, 1.01 mmol). The mixture was stirred at 25° C. for 1 hour. The mixture was diluted with H₂O (10 mL) and extracted with ethyl acetate (5 mL×3). The combined organic layer was washed with brine (5 mL×3), dried over anhydrous Na₂SO₄, filtered, and concentrated in vacuo. The residue was purified by prep-HPLC (column: Phenomenex luna C18 150*25 mm*10 um; mobile phase: [water(FA)-ACN]; gradient: 22%-42% B over 10 min) to give tert-butyl 4-(2-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)amino)-2-oxoethyl)piperazine-1-carboxylate (515 mg, 767.67 μmol, 75.84% yield) as a white solid. ¹H NMR: CDCl₃, 400 MHz. δ 8.71 (s, 1H), 7.93 (d, J=8.0 Hz, 1H), 7.47 (d, J=8.0 Hz, 1H), 7.44-7.35 (m, 4H), 5.14-5.06 (m, 1H), 4.79-4.72 (m, 1H), 4.55-4.47 (m, 2H), 4.15-4.09 (m, 1H), 3.66-3.59 (m, 1H), 3.57-3.54 (m, 4H), 3.19-3.05 (m, 4H), 2.63-2.46 (m, 7H), 1.52-1.43 (m, 12H), 1.07 (s, 9H). LCMS: RT=0.479 min, m/z 671.4[M+H]⁺.

### B. Step 2

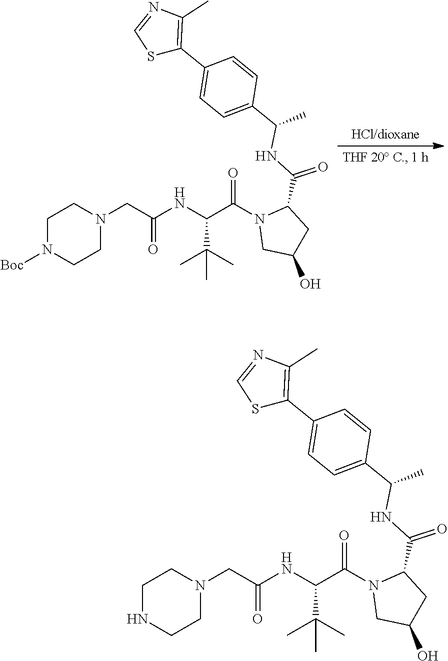 [SMILES: Cc1ncsc1-c1ccc([C@H](C)NC(=O)[C@@H]2C[C@@H](O)CN2C(=O)[C@@H](NC(=O)CN2CCN(C(=O)OC(C)(C)C)CC2)C(C)(C)C)cc1 ; Cc1ncsc1-c1ccc([C@H](C)NC(=O)[C@@H]2C[C@@H](O)CN2C(=O)[C@@H](NC(=O)CN2CCNCC2)C(C)(C)C)cc1]

To a solution of tert-butyl 4-(2-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)amino)-2-oxoethyl)piperazine-1-carboxylate (515 mg, 767.67 μmol in THE (3 mL) was added HCl/dioxane (4 M, 3 mL). The mixture was stirred at 20° C. for 1 hour. The reaction mixture was concentrated under reduced pressure to give a crude product (2S,4R)-1-((S)-3,3-dimethyl-2-(2-(piperazin-1-yl)acetamido)butanoyl)-4-hydroxy-N—((S)-1-(4-(4-methylthiazol-5-yl)phenyl)ethyl)pyrrolidine-2-carboxamide (451 mg, crude, HCl) as a white solid. LCMS: RT=0.415 min, m/z 571.3 [M+H]⁺.

### C. Step 3

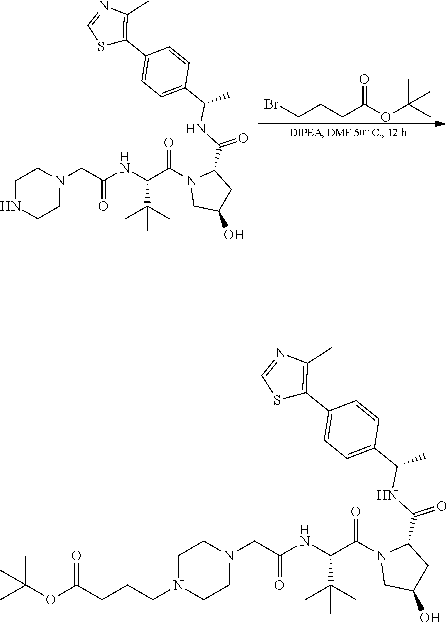 [SMILES: Cc1ncsc1-c1ccc([C@H](C)NC(=O)[C@@H]2C[C@@H](O)CN2C(=O)[C@@H](NC(=O)CN2CCNCC2)C(C)(C)C)cc1 ; CC(C)(C)OC(=O)CCCBr ; Cc1ncsc1-c1ccc([C@H](C)NC(=O)[C@@H]2C[C@@H](O)CN2C(=O)[C@@H](NC(=O)CN2CCN(CCCC(=O)OC(C)(C)C)CC2)C(C)(C)C)cc1]

To a solution of (2S,4R)-1-((S)-3,3-dimethyl-2-(2-(piperazin-1-yl)acetamido)butanoyl)-4-hydroxy-N—((S)-1-(4-(4-methylthiazol-5-yl)phenyl)ethyl)pyrrolidine-2-carboxamide (400 mg, 584.14 μmol, HCl) in DMF (3 mL) was added DIPEA (150.99 mg, 1.17 mmol, 203.49 μL) and tert-butyl 4-bromobutanoate (260.65 mg, 1.17 mmol). The mixture was stirred at 50° C. for 12 hours. The mixture was diluted with H₂O (6 mL) and extracted with ethyl acetate (3 mL×3). The combined organic layers were washed with brine (3 mL×3), dried over anhydrous Na₂SO₄, filtered, and concentrated in vacuo. The residue was purified by prep-HPLC (column: Phenomenex luna C18 150*25 mm*10 um; mobile phase: [water(FA)-ACN]; gradient: 19%-39% B over 10 min) to give tert-butyl 4-(4-(2-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)amino)-2-oxoethyl)piperazin-1-yl)butanoate (361 mg, 506.35 μmol, 86.68% yield) as a white solid. ¹H NMR: CDCl₃, 400 MHz. δ 8.69 (s, 1H), 8.27 (s, 1H), 7.67 (d, J=8.8 Hz, 1H), 7.44-7.35 (m, 5H), 5.13-5.04 (m, 1H), 4.71 (t, J=8.0 Hz, 1H), 4.55-4.48 (m, 2H), 4.14-4.06 (m, 1H), 3.64-3.58 (m, 1H), 3.13-3.08 (m, 2H), 3.02-2.74 (m, 10H), 2.52 (s, 3H), 2.47-2.40 (m, 1H), 2.30 (t, J=7.0 Hz, 2H), 2.10 (dd, J=8.3, 13.3 Hz, 1H), 1.99-1.89 (m, 2H), 1.48 (d, J=6.8 Hz, 3H), 1.44 (s, 9H), 1.04 (s, 9H). LCMS: RT=0.477 min, m/z 713.5[M+H]⁺.

### D. Step 4

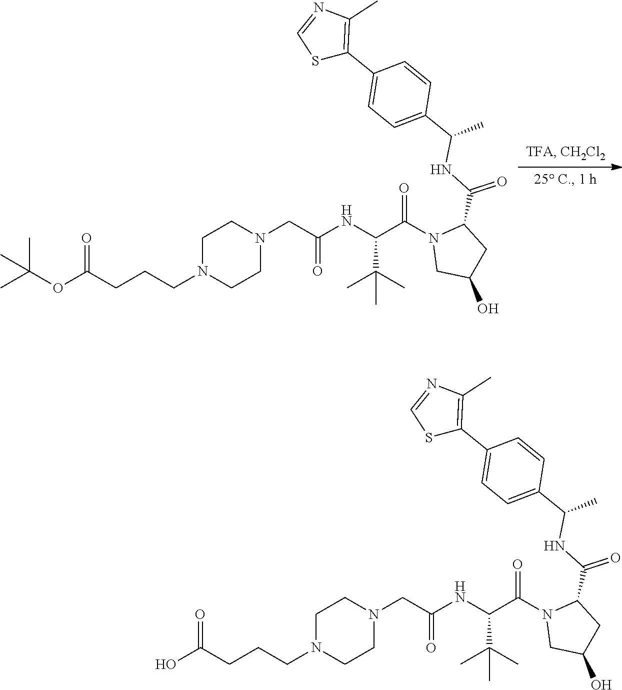 [SMILES: Cc1ncsc1-c1ccc([C@H](C)NC(=O)[C@@H]2C[C@@H](O)CN2C(=O)[C@@H](NC(=O)CN2CCN(CCCC(=O)OC(C)(C)C)CC2)C(C)(C)C)cc1 ; Cc1ncsc1-c1ccc([C@H](C)NC(=O)[C@@H]2C[C@@H](O)CN2C(=O)[C@@H](NC(=O)CN2CCN(CCCC(=O)O)CC2)C(C)(C)C)cc1]

To a solution of tert-butyl 4-(4-(2-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)amino)-2-oxoethyl)piperazin-1-yl)butanoate (351 mg, 492.33 μmol) in CH₂Cl₂ (2 mL) was added TFA (1.54 g, 13.51 mmol, 1 mL). The mixture was stirred at 25° C. for 1 hour. The reaction mixture was concentrated under reduced pressure to remove solvent. The crude compound 4-(4-(2-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)amino)-2-oxoethyl)piperazin-1-yl)butanoic acid (416 mg, crude) was obtained as yellow oil and was used into the next step without further purification. LCMS: RT=0.432 min, m/z 657.4[M+H]⁺.

### E. Step 5

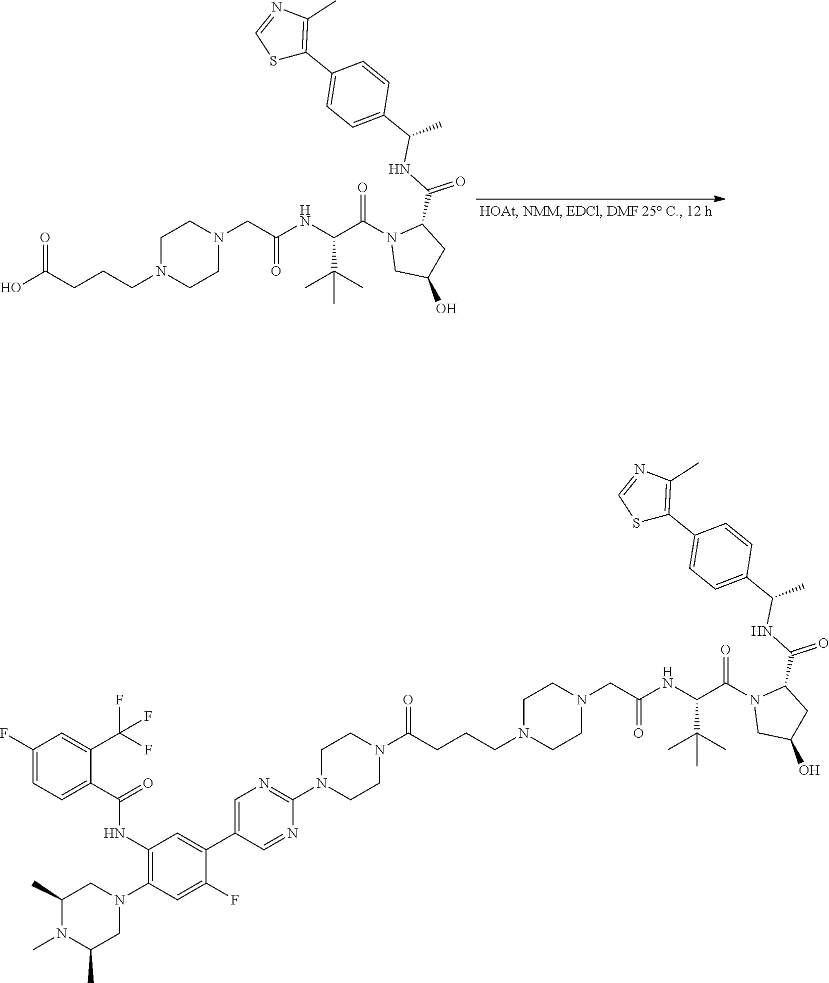 [SMILES: Cc1ncsc1-c1ccc([C@H](C)NC(=O)[C@@H]2C[C@@H](O)CN2C(=O)[C@@H](NC(=O)CN2CCN(CCCC(=O)O)CC2)C(C)(C)C)cc1 ; Cc1ncsc1-c1ccc([C@H](C)NC(=O)[C@@H]2C[C@@H](O)CN2C(=O)[C@@H](NC(=O)CN2CCN(CCCC(=O)N3CCN(c4ncc(-c5cc(NC(=O)c6ccc(F)cc6C(F)(F)F)c(N6C[C@@H](C)N(C)[C@@H](C)C6)cc5F)cn4)CC3)CC2)C(C)(C)C)cc1]

To a solution of 4-(4-(2-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)amino)-2-oxoethyl)piperazin-1-yl)butanoic acid (300 mg, 456.74 μmol) in DMF (3 mL) was added NMM (115.49 mg, 1.14 mmol, 125.54 μL), EDCI (87.56 mg, 456.74 μmol), HOAt (20.72 mg, 76.12 mol) and 4-fluoro-N-[4-fluoro-5-(2-piperazin-1-ylpyrimidin-5-yl)-2-[(3R,5S)-3,4,5-trimethylpiperazin-1-yl]phenyl]-2-(trifluoromethyl)benzamide (238.29 mg, 380.61 μmol, HCl). The mixture was stirred at 25° C. for 12 hours. The mixture was diluted with H₂O (6 mL) and extracted with ethyl acetate (3 mL×3). The combined organic layers were washed with brine (3 mL×3), dried over anhydrous Na₂SO₄, filtered, and concentrated in vacuo. The residue was purified by prep-HPLC (column: Waters Xbridge C18 150*50 mm*10 um; mobile phase: [water(NH₄HCO₃)-ACN]; gradient: 40%-70% B over 10 min) to give (2S,4R)-1-((S)-2-(2-(4-(4-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-4-oxobutyl)piperazin-1-yl)acetamido)-3,3-dimethylbutanoyl)-4-hydroxy-N—((S)-1-(4-(4-methylthiazol-5-yl)phenyl)ethyl)pyrrolidine-2-carboxamide (83.36 mg, 66.39 μmol, 17.44% yield, 97.84% purity) as a white solid ¹H NMR: CDCl₃, 400 MHz. δ 8.88 (s, 1H), 7.83 (d, J=9.2 Hz, 1H), 7.60-7.40 (m, 8H), 7.30-7.24 (m, 1H), 7.20 (s, 1H), 6.97 (d, J=8.8 Hz, 1H), 4.68-4.64 (m, 1H), 4.62-4.47 (m, 3H), 4.43-4.34 (m, 3H), 4.12 (t, J=7.2 Hz, 2H), 4.01 (t, J=6.4 Hz, 2H), 3.95-3.89 (m, 1H), 3.85-3.78 (m, 1H), 3.59-3.54 (m, 2H), 3.00-2.92 (m, 2H), 2.74-2.64 (m, 2H), 2.49 (s, 3H), 2.36-2.19 (m, 3H), 2.15-2.04 (m, 1H), 1.76-1.70 (m, 2H), 1.66-1.58 (m, 2H), 1.52-1.43 (m, 2H), 1.41-1.34 (m, 6H), 1.06-1.01 (m, 9H). LCMS: RT=0.827 min, m/z 1228.8 [M+H]⁺.

### Example B-6. Synthesis of (2S,4R)-1-((S)-2-(3-(4-(3-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-3-oxopropyl)piperazin-1-yl)propanamido)-3,3-dimethylbutanoyl)-4-hydroxy-N—((S)-1-(4-(4-methylthiazol-5-yl)phenyl)ethyl)pyrrolidine-2-carboxamide

The title compound was prepared using general procedures described for (2S,4R)-1-((S)-2-(2-(4-(4-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-4-oxobutyl)piperazin-1-yl)acetamido)-3,3-dimethylbutanoyl)-4-hydroxy-N—((S)-1-(4-(4-methylthiazol-5-yl)phenyl)ethyl)pyrrolidine-2-carboxamide ¹H NMR: CD³OD, 400 MHz. S 8.86 (s, 1H), 8.57 (s, 2H), 8.01 (d, J=8.4 Hz, 1H), 7.81-7.73 (m, 1H), 7.68-7.62 (m, 1H), 7.60-7.51 (m, 1H), 7.46-7.38 (m, 4H), 7.10 (d, J=12.0 Hz, 1H), 5.04-4.98 (m, 1H), 4.89 (m, 1H), 4.62 (s, 1H), 4.61-4.53 (m, 2H), 4.43 (m, 1H), 3.98-3.92 (m, 2H), 3.90-3.83 (m, 3H), 3.77-3.72 (m, 1H), 3.72-3.67 (m, 4H), 3.07-3.03 (m, 2H), 2.80-2.75 (m, 2H), 2.73-2.55 (m, 11H), 2.49-2.41 (m, 7H), 2.37-2.28 (m, 4H), 2.19-2.13 (m, 2H), 2.02-1.92 (m, 1H), 1.51 (d, J=7.2 Hz, 3H), 1.15 (d, J=6.4 Hz, 6H), 1.06 (s, 9H). LCMS: RT=1.289 min, m/z 1228.6 [M+H]⁺

### Example B-7. Synthesis of (2S,4R)-1-((S)-2-(4-(4-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)piperazin-1-yl)butanamido)-3,3-dimethylbutanoyl)-4-hydroxy-N—((S)-1-(4-(4-methylthiazol-5-yl)phenyl)ethyl)pyrrolidine-2-carboxamide

### A. Step 1

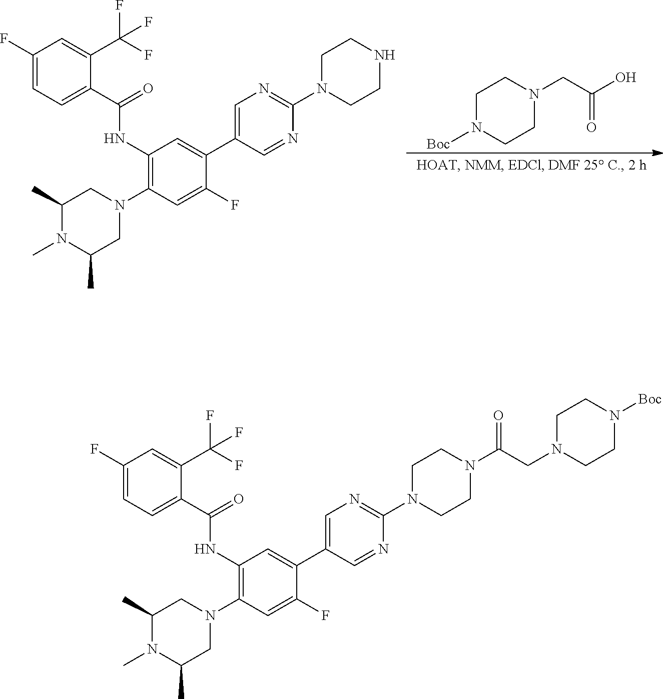 [SMILES: C[C@@H]1CN(c2cc(F)c(-c3cnc(N4CCNCC4)nc3)cc2NC(=O)c2ccc(F)cc2C(F)(F)F)C[C@H](C)N1C ; CC(C)(C)OC(=O)N1CCN(CC(=O)O)CC1 ; C[C@@H]1CN(c2cc(F)c(-c3cnc(N4CCN(C(=O)CN5CCN(C(=O)OC(C)(C)C)CC5)CC4)nc3)cc2NC(=O)c2ccc(F)cc2C(F)(F)F)C[C@H](C)N1C]

To a solution of 2-(4-(tert-butoxycarbonyl)piperazin-1-yl)acetic acid (93.65 mg, 383.35 μmol) in DMF (3 mL) was added NMM (96.94 mg, 958.37 μmol, 105.37 μL), EDCI (73.49 mg, 383.35 μmol), HOAt (8.70 mg, 63.89 μmol) and 4-fluoro-N-(4-fluoro-5-(2-(piperazin-1-yl)pyrimidin-5-yl)-2-((3R,5S)-3,4,5-trimethylpiperazin-1-yl)phenyl)-2-(trifluoromethyl)benzamide (200 mg, 319.46 μmol, HCl). The mixture was stirred at 25° C. for 2 hours. The mixture was diluted with H₂O (10 mL) and extracted with ethyl acetate (5 mL×3). The combined organic layer was washed with brine (5 mL×3), dried over anhydrous Na₂SO₄, filtered, and concentrated in vacuo. The residue was purified by prep-HPLC (column: Phenomenex luna C18 150*25 mm*10 um; mobile phase: [water(FA)-ACN]; gradient: 12%-42% B over 10 min) to give tert-butyl 4-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)piperazine-1-carboxylate (221 mg, 270.88 μmol, 84.79% yield) as a white solid. LCMS: RT=0.809 min, m/z 816.5[M+H]⁺.

### B. Step 2

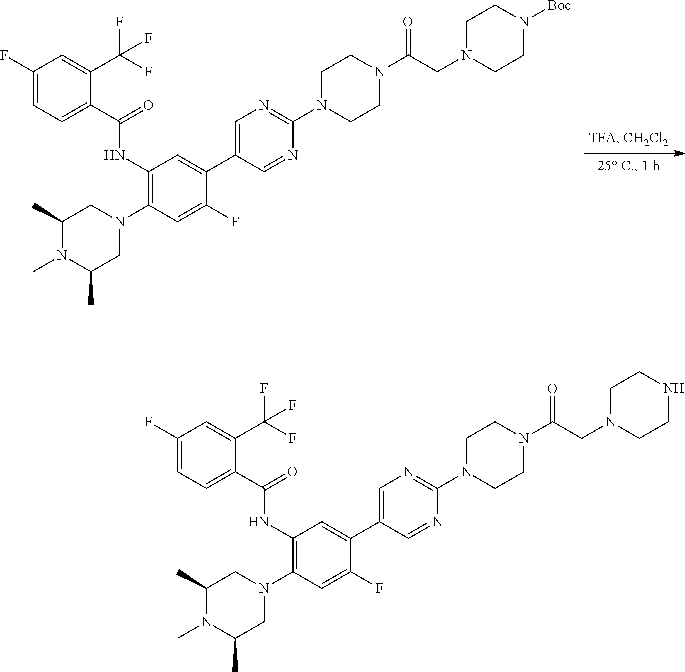 [SMILES: C[C@@H]1CN(c2cc(F)c(-c3cnc(N4CCN(C(=O)CN5CCN(C(=O)OC(C)(C)C)CC5)CC4)nc3)cc2NC(=O)c2ccc(F)cc2C(F)(F)F)C[C@H](C)N1C ; C[C@@H]1CN(c2cc(F)c(-c3cnc(N4CCN(C(=O)CN5CCNCC5)CC4)nc3)cc2NC(=O)c2ccc(F)cc2C(F)(F)F)C[C@H](C)N1C]

To a solution of tert-butyl 4-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)piperazine-1-carboxylate (221 mg, 270.88 μmol) in CH₂Cl₂ (3 mL) was added TFA (92.66 mg, 812.63 μmol, 60.36 μL). The mixture was stirred at 25° C. for 1 hour. The reaction mixture was concentrated in vacuo to give a crude product 4-fluoro-N-(4-fluoro-5-(2-(4-(2-(piperazin-1-yl)acetyl)piperazin-1-yl)pyrimidin-5-yl)-2-((3R,5S)-3,4,5-trimethylpiperazin-1-yl)phenyl)-2-(trifluoromethyl)benzamide (256 mg, crude, TFA) as yellow oil and was used into the next step without further purification. LCMS: RT=0.411 min, m/z 716.4 [M+H]⁺.

### C. Step 3

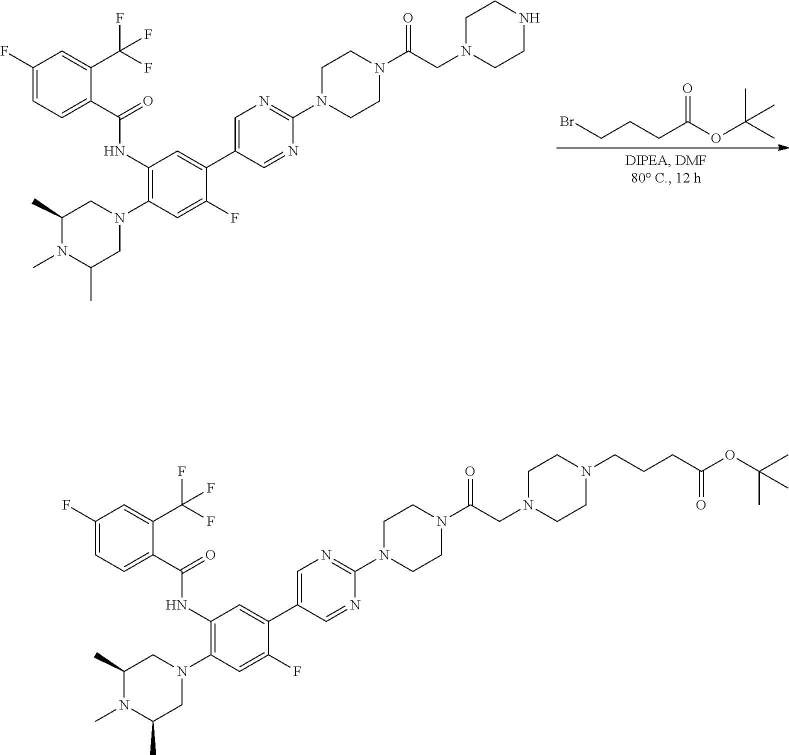 [SMILES: CC1CN(c2cc(F)c(-c3cnc(N4CCN(C(=O)CN5CCNCC5)CC4)nc3)cc2NC(=O)c2ccc(F)cc2C(F)(F)F)C[C@H](C)N1C ; CC(C)(C)OC(=O)CCCBr ; C[C@@H]1CN(c2cc(F)c(-c3cnc(N4CCN(C(=O)CN5CCN(CCCC(=O)OC(C)(C)C)CC5)CC4)nc3)cc2NC(=O)c2ccc(F)cc2C(F)(F)F)C[C@H](C)N1C]

To a solution of 4-fluoro-N-(4-fluoro-5-(2-(4-(2-(piperazin-1-yl)acetyl)piperazin-1-yl)pyrimidin-5-yl)-2-((3R,5S)-3,4,5-trimethylpiperazin-1-yl)phenyl)-2-(trifluoromethyl)benzamide (193 mg, 232.59 μmol, TFA) in DMF (3 mL) was added DIPEA (90.18 mg, 697.77 μmol, 203.49 μL) and tert-butyl 4-bromobutanoate (103.79 mg, 465.18 μmol) at 25° C. The mixture was stirred at 80° C. for 12 hours. The mixture was diluted with H₂O (6 mL) and extracted with ethyl acetate (3 mL×3). The combined organic layers were washed with brine (3 mL×3), dried over anhydrous Na₂SO₄, filtered, and concentrated in vacuo. The residue was purified by prep-HPLC (column: Phenomenex luna C18 150*40 mm*15 um; mobile phase: [water(FA)-ACN]; gradient: 13%-43% B over 15 min) to give tert-butyl 4-(4-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)piperazin-1-yl)butanoate (190.3 mg, 221.81 μmol, 95.36% yield) as a yellow solid. LCMS: RT=0.471 min, m/z 858.5[M+H]⁺.

### D. Step 4

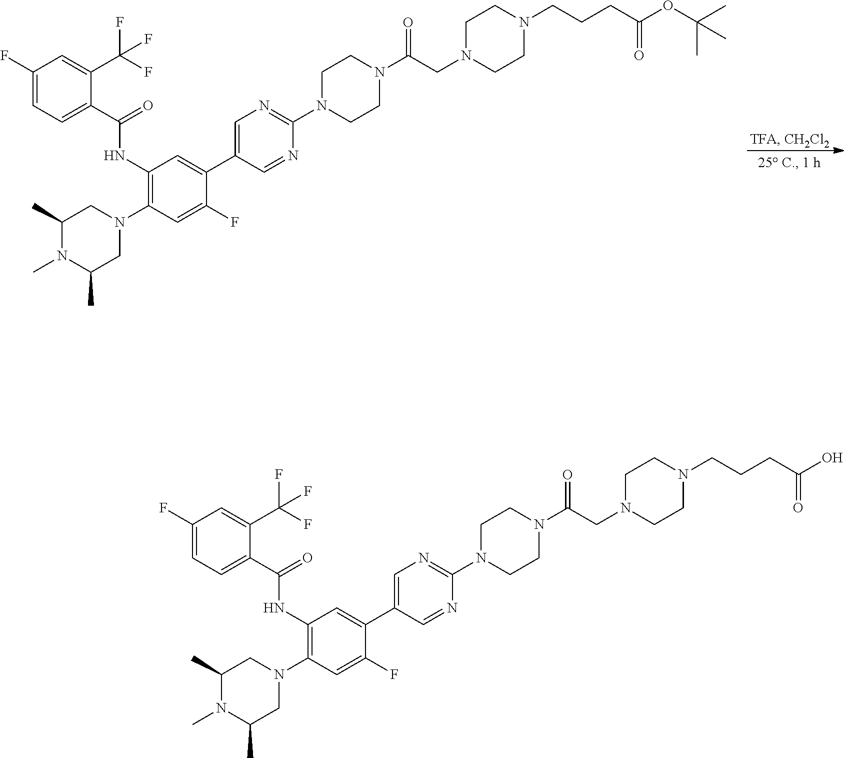 [SMILES: C[C@@H]1CN(c2cc(F)c(-c3cnc(N4CCN(C(=O)CN5CCN(CCCC(=O)OC(C)(C)C)CC5)CC4)nc3)cc2NC(=O)c2ccc(F)cc2C(F)(F)F)C[C@H](C)N1C ; C[C@@H]1CN(c2cc(F)c(-c3cnc(N4CCN(C(=O)CN5CCN(CCCC(=O)O)CC5)CC4)nc3)cc2NC(=O)c2ccc(F)cc2C(F)(F)F)C[C@H](C)N1C]

To a solution of tert-butyl 4-(4-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)piperazin-1-yl)butanoate (190 mg, 221.46 μmol) in CH₂Cl₂ (4 mL) was added TFA (1.54 g, 13.51 mmol, 1 mL). The mixture was stirred at 25° C. for 1 hour. The reaction mixture was concentrated in vacuo to remove solvent. The crude compound 4-(4-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)piperazin-1-yl)butanoic acid (216 mg, crude) was obtained as yellow oil and was used into the next step without further purification. LCMS: RT=0.421 min, m. 802.4[M+H]⁺.

### E. Step 5

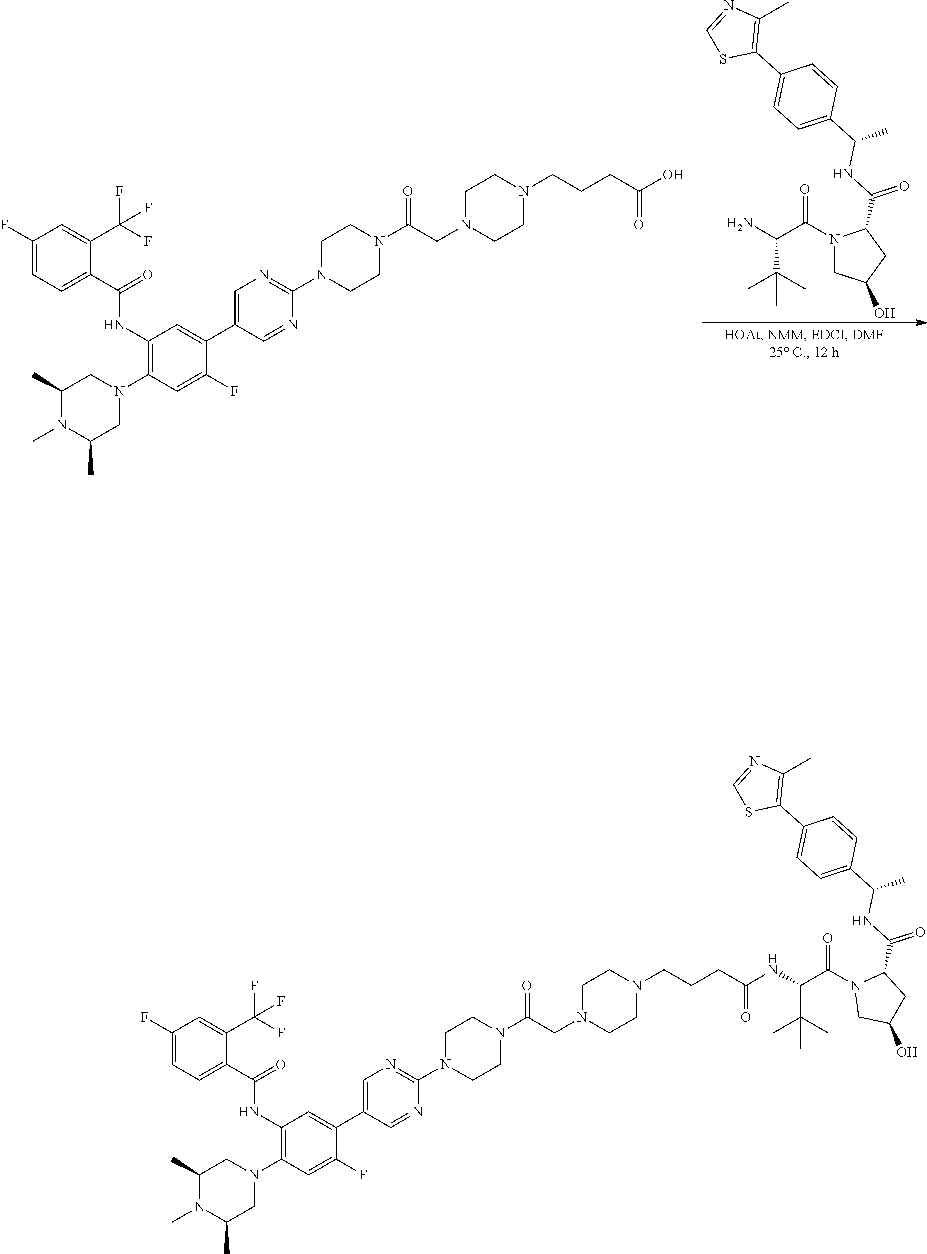 [SMILES: C[C@@H]1CN(c2cc(F)c(-c3cnc(N4CCN(C(=O)CN5CCN(CCCC(=O)O)CC5)CC4)nc3)cc2NC(=O)c2ccc(F)cc2C(F)(F)F)C[C@H](C)N1C ; Cc1ncsc1-c1ccc([C@H](C)NC(=O)[C@@H]2C[C@@H](O)CN2C(=O)[C@@H](N)C(C)(C)C)cc1 ; Cc1ncsc1-c1ccc([C@H](C)NC(=O)[C@@H]2C[C@@H](O)CN2C(=O)[C@@H](NC(=O)CCCN2CCN(CC(=O)N3CCN(c4ncc(-c5cc(NC(=O)c6ccc(F)cc6C(F)(F)F)c(N6C[C@@H](C)N(C)[C@@H](C)C6)cc5F)cn4)CC3)CC2)C(C)(C)C)cc1]

To a solution of compound 4-(4-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)piperazin-1-yl)butanoic acid (177 mg, 220.74 μmol) in DMF (3 mL) was added NMM (55.82 mg, 551.85 μmol, 60.67 μL), EDCI (42.32 mg, 220.74 μmol), HOAt (5.01 mg, 36.79 μmol) and (2S,4R)-1-((S)-2-amino-3,3-dimethylbutanoyl)-4-hydroxy-N—((S)-1-(4-(4-methylthiazol-5-yl)phenyl)ethyl)pyrrolidine-2-carboxamide (81.78 mg, 183.95 μmol, HCl). The mixture was stirred at 25° C. for 12 hours. The reaction mixture was concentrated in vacuo to remove solvent. The residue was purified by prep-HPLC (column: Phenomenex luna C18 150*25 mm*10 um; mobile phase: [water(FA)-ACN]; gradient: 12%-42% B over 10 min) to give (2S,4R)-1-((S)-2-(4-(4-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)piperazin-1-yl)butanamido)-3,3-dimethylbutanoyl)-4-hydroxy-N—((S)-1-(4-(4-methylthiazol-5-yl)phenyl)ethyl)pyrrolidine-2-carboxamide (58.8 mg, 47.17 μmol, 25.64% yield, 98.55% purity) as an off-white solid. ¹H NMR: CDCl₃, 400 MHz. δ 8.68 (s, 1H), 8.62-8.35 (m, 5H), 7.69-7.64 (m, 1H), 7.55-7.47 (m, 2H), 7.43-7.35 (m, 5H), 7.03 (d, J=11.2 Hz, 1H), 6.71 (d, J=8.4 Hz, 1H), 5.12-5.03 (m, 1H), 4.77 (t, J=8.0 Hz, 1H), 4.58 (d, J=8.4 Hz, 1H), 4.50-4.45 (m, 1H), 4.16-4.11 (m, 1H), 3.97-3.86 (m, 4H), 3.73-3.61 (m, 4H), 3.60-3.53 (m, 1H), 3.30 (s, 2H), 2.87-2.56 (m, 14H), 2.54 (s, 3H), 2.23-1.84 (m, 11H), 1.48 (d, J=6.9 Hz, 3H), 1.17-1.10 (m, 6H), 1.05 (s, 9H). LCMS: RT=0.825 min, m/z 1228.8 [M+H]⁺.

### Example B-8. Synthesis of (2S,4R)-1-((S)-2-(2-(3-(5-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-5-oxopentyl)phenyl)acetamido)-3,3-dimethylbutanoyl)-4-hydroxy-N—((S)-1-(4-(4-methylthiazol-5-yl)phenyl)ethyl)pyrrolidine-2-carboxamide

### A. Step 1

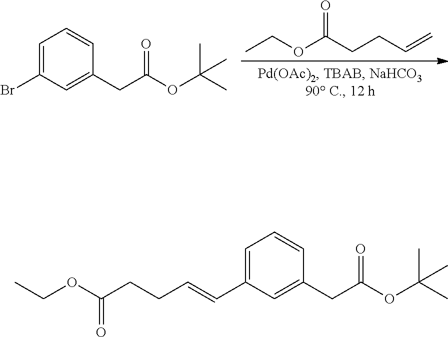

A mixture of tert-butyl 2-(3-bromophenyl)acetate (3 g, 11.06 mmol), ethyl pent-4-enoate (2.84 g, 22.13 mmol), Pd(OAc)₂ (248.40 mg, 1.11 mmol), TBAB (3.57 g, 11.06 mmol) and NaHCO₃ (3.72 g, 44.26 mmol, 1.72 mL) in DMF (30 mL) was degassed and purged with N₂ for 3 times, and then the mixture was stirred at 90° C. for 12 hours under N₂ atmosphere. The mixture was diluted with H₂O (50 mL) and extracted with ethyl acetate (50 mL×3). The combined organic layer was washed with brine (50 mL×3), dried over anhydrous Na₂SO₄, filtered, and concentrated in vacuo. The residue was purified by flash silica gel chromatography (ISCO®; 80 g SepaFlash® Silica Flash Column, Eluent of 0-10% ethyl acetate/Petroleum ether gradient @50 mL/min) to give to give ethyl (E)-5-(3-(2-(tert-butoxy)-2-oxoethyl)phenyl)pent-4-enoate (540 mg, 1.70 mmol, 15.33% yield) as colorless oil. ¹H NMR: CDCl₃, 400 MHz. δ 7.57-7.21 (m, 3H), 7.17-7.08 (m, 1H), 6.49-6.38 (m, 1H), 6.30-6.16 (m, 1H), 4.28-4.12 (m, 2H), 3.62-3.44 (m, 2H), 2.88-2.62 (m, 1H), 2.60-2.43 (m, 3H), 1.46 (s, 9H), 1.35-1.25 (m, 3H).

### B. Step 2

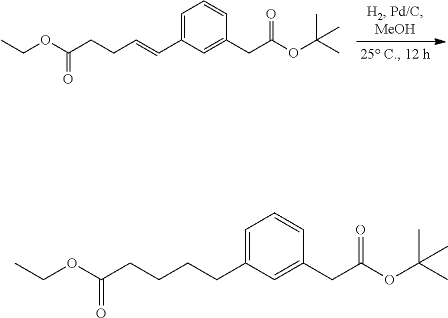

To a solution of ethyl (E)-5-(3-(2-(tert-butoxy)-2-oxoethyl)phenyl)pent-4-enoate 540 mg, 1.70 mmol) in MeOH (10 mL) was added Pd/C (200 mg, 187.93 μmol, 10% purity) under N₂ atmosphere. The mixture was degassed and purged with H₂ for three times. The mixture was stirred under H₂ (50 Psi) at 25° C. for 12 hours. The reaction mixture was filtered through a pad of celite. The filtrate was concentrated in vacuo to give ethyl 5-(3-(2-(tert-butoxy)-2-oxoethyl)phenyl)pentanoate (490 mg, crude) as a colorless oil. ¹H NMR: CDCl₃, 400 MHz. δ 7.19-7.12 (m, 1H), 7.05-6.96 (m, 3H), 4.04 (q, J=7.2 Hz, 2H), 3.40 (s, 2H), 2.66-2.43 (m, 2H), 2.30-2.14 (m, 2H), 1.63-1.51 (m, 4H), 1.36 (s, 9H), 1.18 (t, J=7.2 Hz, 3H).

### C. Step 3

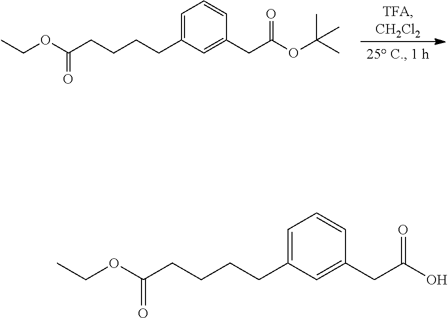

To a solution of ethyl 5-(3-(2-(tert-butoxy)-2-oxoethyl)phenyl)pentanoate (490 mg, 1.53 mmol) in CH₂Cl₂ (5 mL) was added TFA (7.68 g, 67.31 mmol, 5 mL). The resulting mixture was stirred at 25° C. for 1 hour. The mixture was concentrated in vacuo to give 2-(3-(5-ethoxy-5-oxopentyl)phenyl)acetic acid (480 mg, crude, TFA) as a colorless oil. ¹H NMR: CDCl₃, 400 MHz. δ 7.21-7.15 (m, 1H), 7.06-6.99 (m, 3H), 4.12-3.99 (q, J=7.2 Hz, 2H), 3.61-3.57 (m, 2H), 2.58-2.50 (m, 2H), 2.32-2.23 (m, 2H), 1.64-1.51 (m, 4H), 1.18 (t, J=7.2 Hz, 3H).

### D. Step 4

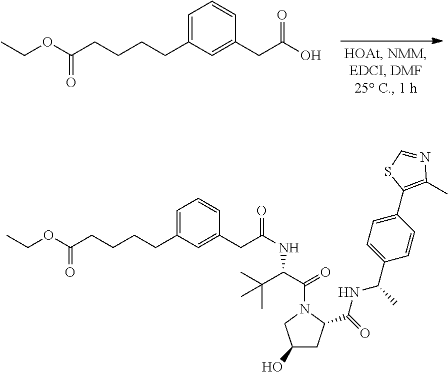 [SMILES: CCOC(=O)CCCCc1cccc(CC(=O)O)c1 ; CCOC(=O)CCCCc1cccc(CC(=O)N[C@H](C(=O)N2C[C@H](O)C[C@H]2C(=O)N[C@@H](C)c2ccc(-c3scnc3C)cc2)C(C)(C)C)c1]

To a solution of 2-(3-(5-ethoxy-5-oxopentyl)phenyl)acetic acid (400 mg, 1.06 mmol, TFA), (2S,4R)-1-((S)-2-amino-3,3-dimethylbutanoyl)-4-hydroxy-N—((S)-1-(4-(4-methylthiazol-5-yl)phenyl)ethyl)pyrrolidine-2-carboxamide (470.04 mg, 1.06 mmol) and NMM (320.81 mg, 3.17 mmol, 348.71 μL) in DMSO (10 mL) were added EDCI (304.02 mg, 1.59 mmol) and HOAt (215.86 mg, 1.59 mmol, 221.85 μL). The resulting mixture was stirred at 25° C. for 1 hour. The mixture was diluted with H₂O (20 mL) and extracted with ethyl acetate (20 mL×3). The combined organic layers were washed with brine (30 mL×3), dried over anhydrous Na₂SO₄, filtered, and concentrated in vacuo. The residue was purified by flash silica gel chromatography (ISCO®; 12 g SepaFlash® Silica Flash Column, Eluent of 0-10% Dichloromethane/Methanol gradient @30 mL/min) to give ethyl 5-(3-(2-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)amino)-2-oxoethyl)phenyl)pentanoate (226 mg, 327.11 μmol, 30.94% yield) as a colorless oil. LCMS: RT=0.591 min, m/z 691.4 [M+H]⁺.

### E. Step 5

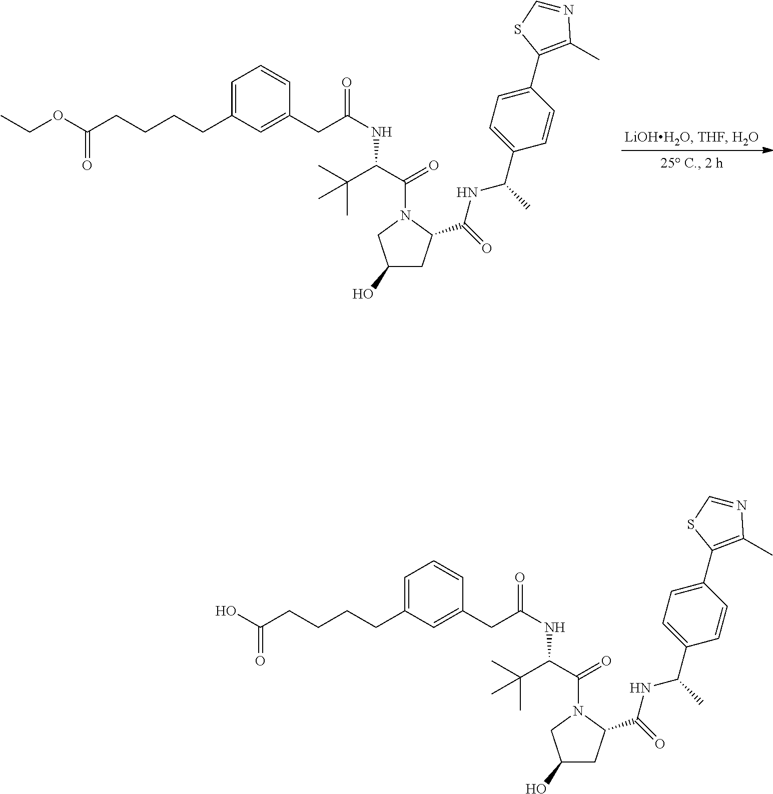 [SMILES: CCOC(=O)CCCCc1cccc(CC(=O)N[C@H](C(=O)N2C[C@H](O)C[C@H]2C(=O)N[C@@H](C)c2ccc(-c3scnc3C)cc2)C(C)(C)C)c1 ; Cc1ncsc1-c1ccc([C@H](C)NC(=O)[C@@H]2C[C@@H](O)CN2C(=O)[C@@H](NC(=O)Cc2cccc(CCCCC(=O)O)c2)C(C)(C)C)cc1]

To a solution of ethyl 5-(3-(2-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)amino)-2-oxoethyl)phenyl)pentanoate (226 mg, 327.11 μmol) in THF (3 mL)/H₂O (1 mL) was added LiOH·H₂O (41.18 mg, 981.34 μmol). The resulting mixture was stirred at 25° C. for 2 hours.

The mixture was then acidified to pH=4-5 with 1N HCl. To the reaction mixture were added ethyl acetate (20 mL) and H₂O (10 mL). Layers were separated. The aqueous phase was extracted with ethyl acetate (20 mL×3). The combined organic layers were washed with brine (30 mL×3), dried over anhydrous Na₂SO₄, filtered, and concentrated in vacuo to give 5-(3-(2-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)amino)-2-oxoethyl)phenyl)pentanoic acid (200 mg, 301.73 μmol, 92.24% yield) as a colorless liquid. LCMS: RT=0.525 min, m/z 663.4 [M+H]⁺.

### F. Step 6

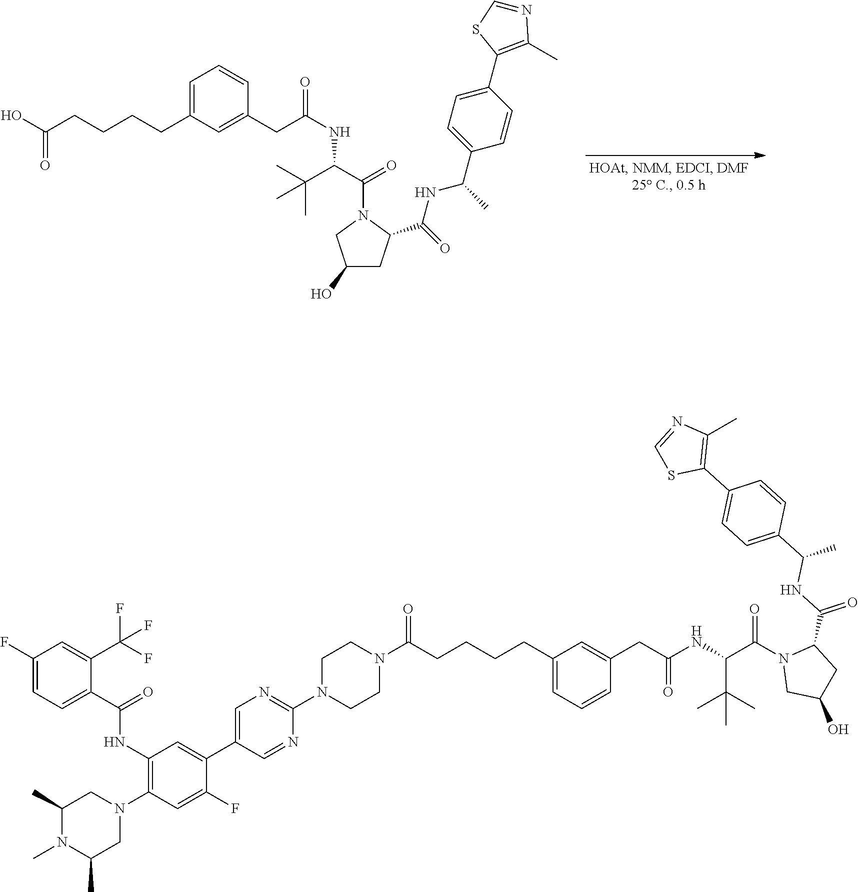 [SMILES: Cc1ncsc1-c1ccc([C@H](C)NC(=O)[C@@H]2C[C@@H](O)CN2C(=O)[C@@H](NC(=O)Cc2cccc(CCCCC(=O)O)c2)C(C)(C)C)cc1 ; Cc1ncsc1-c1ccc([C@H](C)NC(=O)[C@@H]2C[C@@H](O)CN2C(=O)[C@@H](NC(=O)Cc2cccc(CCCCC(=O)N3CCN(c4ncc(-c5cc(NC(=O)c6ccc(F)cc6C(F)(F)F)c(N6C[C@@H](C)N(C)[C@@H](C)C6)cc5F)cn4)CC3)c2)C(C)(C)C)cc1]

To a solution of 5-(3-(2-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)amino)-2-oxoethyl)phenyl)pentanoic acid (150 mg, 226.30 μmol), 4-fluoro-N-(4-fluoro-5-(2-(piperazin-1-yl)pyrimidin-5-yl)-2-((3R,5S)-3,4,5-trimethylpiperazin-1-yl)phenyl)-2-(trifluoromethyl)benzamide (141.68 mg, 226.30 μmol, HCl) and NMM (45.78 mg, 452.60 μmol, 49.76 μL) in DMSO (2 mL) were added EDCI (65.07 mg, 339.45 μmol) and HOAt (46.20 mg, 339.45 μmol, 47.48 μL). The resulting mixture was stirred at 25° C. for 0.5 hour. The mixture was concentrated in vacuo. The residue was purified by prep-HPLC (column: Phenomenex luna C18 150*25 mm*10 um; mobile phase: [water(FA)-ACN]; gradient: 27%-57% B over 10 min). The desired compound was further separated by chiral SFC (column: DAICEL CHIRALCEL OD (250 mm*30 mm, 10 um); mobile phase: [CO₂-ACN/EtOH(0.1% NH₃H₂O)]; B %: 45%, isocratic elution mode) to give (2S,4R)-1-((S)-2-(2-(3-(5-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-5-oxopentyl)phenyl)acetamido)-3,3-dimethylbutanoyl)-4-hydroxy-N—((S)-1-(4-(4-methylthiazol-5-yl)phenyl)ethyl)pyrrolidine-2-carboxamide (91.90 mg, 73.44 μmol, 32.45% yield, 98.65% purity) as a white solid. ¹H NMR: MeOD, 400 MHz. δ 8.86 (s, 1H), 8.59-8.50 (m, 2H), 8.06-7.99 (m, 1H), 8.07-7.99 (m, 1H), 7.80-7.69 (m, 1H), 7.67-7.61 (m, 1H), 7.59-7.50 (m, 1H), 7.46-7.32 (m, 4H), 7.26-7.05 (m, 5H), 5.04-4.89 (m, 1H), 4.64-4.53 (m, 2H), 4.46-4.33 (m, 1H), 3.92-3.78 (m, 5H), 3.77-3.50 (m, 7H), 3.15-3.01 (m, 2H), 2.72-2.59 (m, 4H), 2.56-2.45 (m, 6H), 2.40-2.32 (m, 3H), 2.23-2.11 (m, 1H), 2.00-1.88 (m, 1H), 1.78-1.53 (m, 4H), 1.50 (d, J=6.8 Hz, 3H), 1.22-1.13 (m, 6H), 1.02-0.93 (m, 9H). LCMS: RT=1.907 min, m/z 1234.6 [M+H]⁺.

### Example B-9. Synthesis of (2S,4R)-1-((S)-2-(3-(3-(4-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-4-oxobutyl)phenyl)propanamido)-3,3-dimethylbutanoyl)-4-hydroxy-N—((S)-1-(4-(4-methylthiazol-5-yl)phenyl)ethyl)pyrrolidine-2-carboxamide

The title compound was prepared using general procedures described for (2S,4R)-1-((S)-2-(2-(3-(5-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-5-oxopentyl)phenyl)acetamido)-3,3-dimethylbutanoyl)-4-hydroxy-N—((S)-1-(4-(4-methylthiazol-5-yl)phenyl)ethyl)pyrrolidine-2-carboxamide. ¹H NMR: MeOD-d₄, 400 MHz. δ 8.89-8.83 (m, 1H), 8.59-8.51 (m, 2H), 8.05-7.99 (m, 1H), 7.80-7.74 (m, 1H), 7.66-7.62 (m, 1H), 7.58-7.52 (m, 1H), 7.44-7.38 (m, 4H), 7.22-7.16 (m, 1H), 7.13-7.07 (m, 2H), 7.07-7.01 (m, 2H), 4.64-4.53 (m, 3H), 4.45-4.38 (m, 1H), 3.93-3.81 (m, 5H), 3.75-3.64 (m, 3H), 3.61-3.54 (m, 2H), 3.11-3.02 (m, 2H), 2.96-2.86 (m, 2H), 2.69-2.51 (m, 8H), 2.49-2.44 (m, 5H), 2.36 (s, 3H), 2.26-2.11 (m, 1H), 2.00-1.88 (m, 3H), 1.60-1.46 (m, 3H), 1.20-1.13 (m, 6H), 0.97-0.91 (s, 9H). LCMS: RT=1.888 min, m/z 1235.6 [M+H]⁺.

### Example B-10. Synthesis of (2S,4R)-1-((S)-2-(4-(3-(3-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-3-oxopropyl)phenyl)butanamido)-3,3-dimethylbutanoyl)-4-hydroxy-N—((S)-1-(4-(4-methylthiazol-5-yl)phenyl)ethyl)pyrrolidine-2-carboxamide

The title compound was prepared using general procedures described for (2S,4R)-1-((S)-2-(2-(3-(5-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-5-oxopentyl)phenyl)acetamido)-3,3-dimethylbutanoyl)-4-hydroxy-N—((S)-1-(4-(4-methylthiazol-5-yl)phenyl)ethyl)pyrrolidine-2-carboxamide. ¹H NMR: CD₃OD-d₄, 400 MHz. δ 8.88-8.83 (m, 1H), 8.56-8.53 (m, 2H), 8.05-7.99 (m, 1H), 7.84-7.79 (m, 1H), 7.79-7.73 (m, 1H), 7.68-7.62 (m, 1H), 7.59-7.52 (m, 1H), 7.44-7.34 (m, 4H), 7.23-7.17 (m, 1H), 7.13-7.01 (m, 4H), 4.66-4.55 (m, 3H), 4.46-4.33 (m, 1H), 3.93-3.85 (m, 1H), 3.83-3.72 (m, 3H), 3.69-3.50 (m, 6H), 3.14-3.05 (m, 2H), 2.98-2.90 (m, 2H), 2.78-2.70 (m, 2H), 2.69-2.57 (m, 6H), 2.47-2.43 (m, 6H), 2.32-2.13 (m, 3H), 2.01-1.85 (m, 3H), 1.58-1.48 (m, 3H), 1.22-1.18 (m, 6H), 1.06-1.01 (m, 9H). LCMS: =1.882 min, m/z 1234.6 [M+H]⁺.

### Example B-11. Synthesis of (2S,4R)-1-((S)-2-(5-(3-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)phenyl)pentanamido)-3,3-dimethylbutanoyl)-4-hydroxy-N—((S)-1-(4-(4-methylthiazol-5-yl)phenyl)ethyl)pyrrolidine-2-carboxamide

The title compound was prepared using general procedures described for (2S,4R)-1-((S)-2-(2-(3-(5-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-5-oxopentyl)phenyl)acetamido)-3,3-dimethylbutanoyl)-4-hydroxy-N—((S)-1-(4-(4-methylthiazol-5-yl)phenyl)ethyl)pyrrolidine-2-carboxamide. ¹H NMR: 400 MHz. δ 8.90-8.80 (m, 1H), 8.57-8.54 (m, 2H), 8.42 (s, 1H), 8.05 (d, J=8.0 Hz, 1H), 7.83-7.78 (m, 1H), 7.70-7.63 (m, 1H), 7.61-7.54 (m, 1H), 7.48-7.33 (m, 4H), 7.31-7.09 (m, 5H), 5.07-4.95 (m, 1H), 4.65-4.53 (m, 2H), 4.46-4.39 (m, 1H), 3.92-3.79 (m, 5H), 3.77-3.61 (m, 7H), 3.27-3.18 (m, 2H), 3.17-3.05 (m, 2H), 2.90-2.81 (m, 2H), 2.74-2.69 (m, 3H), 2.69-2.61 (m, 2H), 2.51-2.44 (m, 3H), 2.40-2.25 (m, 2H), 2.23-2.14 (m, 1H), 2.02-1.91 (m, 1H), 1.78-1.60 (m, 4H), 1.59-1.48 (m, 3H), 1.36-1.31 (m, 6H), 1.10-0.96 (m, 9H). LCMS: RT=1.878 min, m/z 1234.6 [M+H]⁺.

### Example B-12. Synthesis of (2S,4R)-1-((S)-2-(3-(2-(3-(4-(5-(2-fluoro-5-(4-fluoro-2-(trifluoromethyl)benzamido)-4-((3R,5S)-3,4,5-Trimethylpiperazin-1-yl)phenyl)pyrimidin-2-yl)piperazin-1-yl)-3-oxopropoxy)ethoxy)propanamido)-3,3-dimethylbutanoyl)-4-hydroxy-N—((S)-1-(4-(4-methylthiazol-5-yl)phenyl)ethyl)pyrrolidine-2-carboxamide

The title compound was prepared using general procedures described for (2S,4R)-1-((S)-2-(10-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-10-oxodecanamido)-3,3-dimethylbutanoyl)-4-hydroxy-N—((S)-1-(4-(4-methylthiazol-5-yl)phenyl)ethyl)pyrrolidine-2-carboxamide ¹H NMR: CD₃OD-d₄, 400 MHz. δ 9.75-9.55 (m, 1H), 8.77-8.59 (m, 2H), 8.14-8.03 (m, 1H), 7.86-7.77 (m, 1H), 7.71-7.62 (m, 1H), 7.61-7.42 (m, 5H), 7.37-7.17 (m, 1H), 5.05-4.98 (m, 11H), 4.64 (s, 11H), 4.57 (t, J=8.8 Hz, 11H), 4.48-4.32 (m, 11H), 4.04-3.95 (m, 2H), 3.95-3.89 (m, 2H), 3.89-3.69 (m, 10H), 3.67-3.58 (m, 4H), 3.57-3.46 (m, 2H), 3.43-3.33 (m, 2H), 3.26-2.90 (m, 5H), 2.83-2.72 (m, 2H), 2.61-2.45 (m, 5H), 2.25-2.14 (m, 1H), 2.01-1.88 (m, 1H), 1.59-1.49 (m, 3H), 1.49-1.16 (m, 6H), 1.09-0.98 (m, 9H). LCMS: RT=1.612 min, m/z 1204.4 [M+H]⁺.

### Example B-13. Synthesis of (2S,4R)-1-[(2S)-2-[[2-[3-[3-[2-[4-[5-[2-fluoro-5-[[4-fluoro-2-(trifluoromethyl)benzoyl]amino]-4-[(3R,5S)-3,4,5-trimethylpiperazin-1-yl]phenyl]pyrimidin-2-yl]piperazin-1-yl]-2-oxo-ethyl]phenyl]phenyl]acetyl]amino]-3,3-dimethyl-butanoyl]-4-hydroxy-N-[(1S)-1-[4-(4-methylthiazol-5-yl)phenyl]ethyl]pyrrolidine-2-carboxamide

### A. Step 1

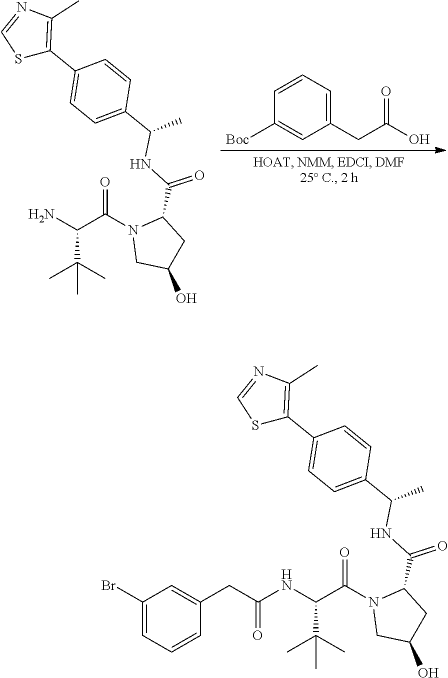 [SMILES: Cc1ncsc1-c1ccc([C@H](C)NC(=O)[C@@H]2C[C@@H](O)CN2C(=O)[C@@H](N)C(C)(C)C)cc1 ; CC(C)(C)OC(=O)c1cccc(CC(=O)O)c1 ; Cc1ncsc1-c1ccc([C@H](C)NC(=O)[C@@H]2C[C@@H](O)CN2C(=O)[C@@H](NC(=O)Cc2cccc(Br)c2)C(C)(C)C)cc1]

To a solution of 2-(3-bromophenyl)acetic acid (377.28 mg, 1.75 mmol) in DMF (10 mL) was added EDCI (310.45 mg, 1.62 mmol), NMM (682.52 mg, 6.75 mmol, 741.87 μL) and HOAt (36.74 mg, 269.91 μmol). (2S,4R)-1-((S)-2-amino-3,3-dimethylbutanoyl)-4-hydroxy-N—((S)-1-(4-(4-methylthiazol-5-yl)phenyl)ethyl)pyrrolidine-2-carboxamide (600 mg, 1.35 mmol) was added. The mixture was stirred at 25° C. for 2 hours. The reaction mixture was diluted with ethyl acetate (10 mL) and water (30 mL). The mixture was extracted with ethyl acetate (10 mL*3). The combined organic layer was washed with brine (20 mL), dried with anhydrous Na₂SO₄, filtered, and concentrated in vacuo. The residue was purified by column chromatography (silica gel, Petroleum ether:Ethyl acetate=3:1 to 1:1) to give (2S,4R)-1-((S)-2-(2-(3-bromophenyl)acetamido)-3,3-dimethylbutanoyl)-4-hydroxy-N—((S)-1-(4-(4-methylthiazol-5-yl)phenyl)ethyl)pyrrolidine-2-carboxamide (470 mg, 732.52 μmol, 54.28% yield) as yellow oil. LCMS: RT=0.561 min, m/z 643.2 [M+H+2]⁺.

### B. Step 2

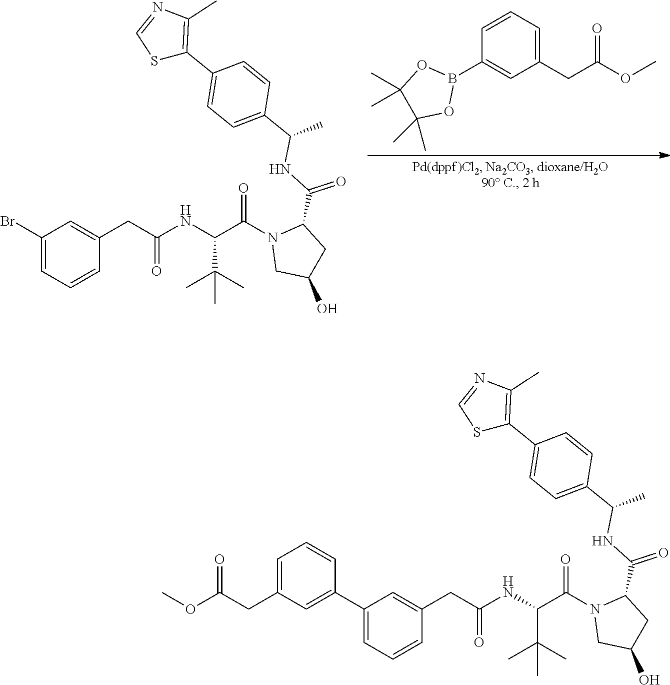

A mixture of (2S,4R)-1-((S)-2-(2-(3-bromophenyl)acetamido)-3,3-dimethylbutanoyl)-4-hydroxy-N—((S)-1-(4-(4-methylthiazol-5-yl)phenyl)ethyl)pyrrolidine-2-carboxamide (220 mg, 342.88 μmol), methyl 2-(3-(4,4,5,5-tetramethyl-1,3,2-dioxaborolan-2-yl)phenyl)acetate (189.36 mg, 685.77 μmol), Pd(dppf)Cl₂ (25.09 mg, 34.29 μmol), Na₂CO₃ (72.68 mg, 685.77 μmol) in dioxane (2 mL) and H₂O (0.4 mL) was degassed and purged with N₂ for 3 times, and then the mixture was stirred at 90° C. for 2 hours under N₂ atmosphere. The reaction mixture was diluted with CH₂Cl₂ (10 mL) and water (10 mL). The mixture was extracted with CH₂Cl₂ (10 mL*3). The combined organic layer was washed with brine (20 mL), dried with anhydrous Na₂SO₄, filtered, and concentrated in vacuo. The residue was purified by column chromatography (silica gel, Dichloromethane:Methanol=1:0 to 10:1) to give methyl 2-(3′-(2-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)amino)-2-oxoethyl)-[1,1′-biphenyl]-3-yl)acetate (183 mg, 257.43 μmol, 75.08% yield) as yellow oil. LCMS: RT=0.579 min, m/z 711.4 [M+H]⁺.

### C. Step 3

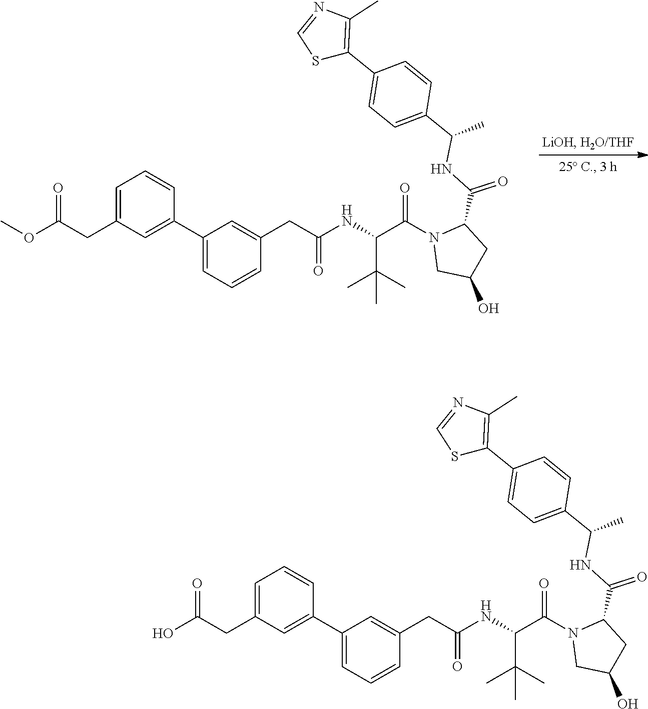 [SMILES: COC(=O)Cc1cccc(-c2cccc(CC(=O)N[C@H](C(=O)N3C[C@H](O)C[C@H]3C(=O)N[C@@H](C)c3ccc(-c4scnc4C)cc3)C(C)(C)C)c2)c1 ; Cc1ncsc1-c1ccc([C@H](C)NC(=O)[C@@H]2C[C@@H](O)CN2C(=O)[C@@H](NC(=O)Cc2cccc(-c3cccc(CC(=O)O)c3)c2)C(C)(C)C)cc1]

To a solution of methyl 2-(3′-(2-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)amino)-2-oxoethyl)-[1,1′-biphenyl]-3-yl)acetate (170 mg, 239.14 μmol) in THF (2 mL) and H₂O (1 mL) was added LiOH H₂O (50.18 mg, 1.20 mmol). The mixture was stirred at 25° C. for 3 hours. The reaction mixture was acidified with 2N HCl to pH=5-6. The reaction mixture was diluted with CH₂Cl₂ (10 mL) and water (10 mL). The mixture was extracted with CH₂Cl₂ (5 mL*3). The combined organic layer was washed with brine (10 mL), dried with anhydrous Na₂SO₄, filtered, and concentrated in vacuo to give 2-(3′-(2-(((S)-1-((2S,4R)-4-hydroxy-2-((((S)-1-(4-(4-methylthiazol-5-yl)phenyl)ethyl)amino)methyl)pyrrolidin-1-yl)-3,3-dimethyl-1-oxobutan-2-yl)amino)-2-oxoethyl)-[1,1′-biphenyl]-3-yl)acetic acid (160 mg, 229.60 μmol, 96.01% yield) as yellow oil. LCMS: RT=0.540 min, m/z 697.3 [M+H]⁺.

### D. Step 4

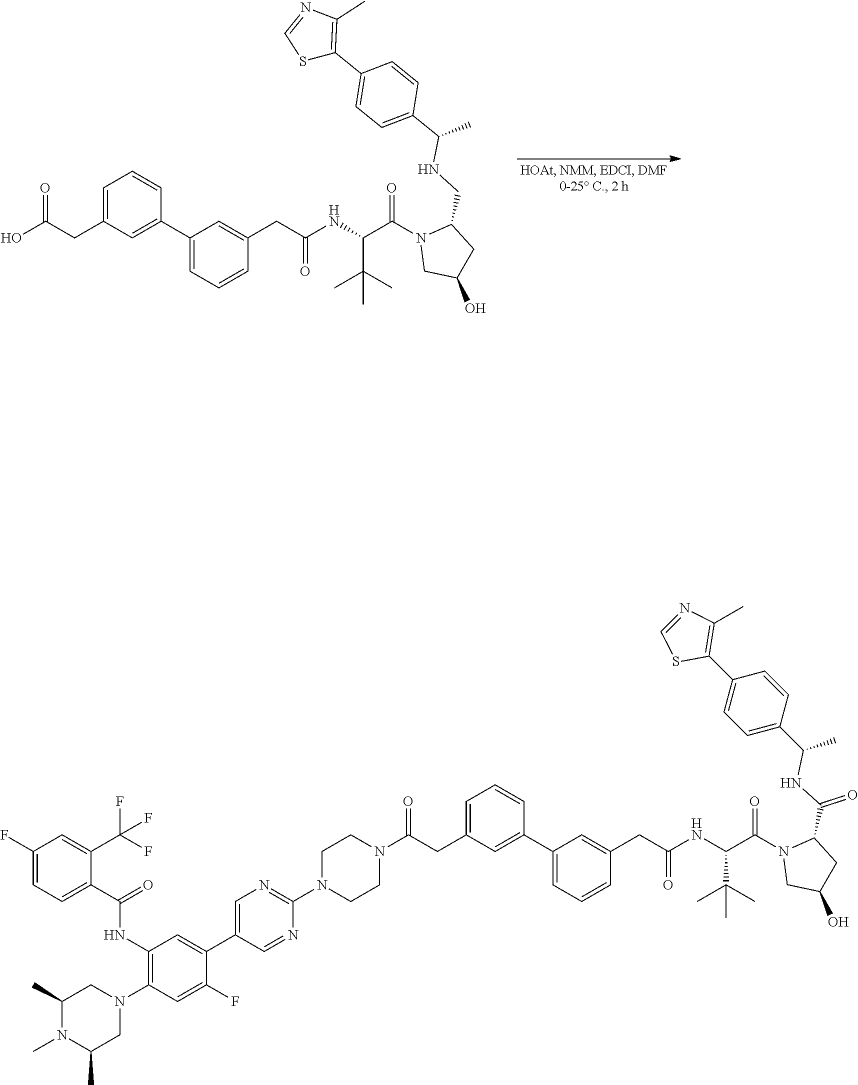 [SMILES: Cc1ncsc1-c1ccc([C@H](C)NC[C@@H]2C[C@@H](O)CN2C(=O)[C@@H](NC(=O)Cc2cccc(-c3cccc(CC(=O)O)c3)c2)C(C)(C)C)cc1 ; Cc1ncsc1-c1ccc([C@H](C)NC(=O)[C@@H]2C[C@@H](O)CN2C(=O)[C@@H](NC(=O)Cc2cccc(-c3cccc(CC(=O)N4CCN(c5ncc(-c6cc(NC(=O)c7ccc(F)cc7C(F)(F)F)c(N7C[C@@H](C)N(C)[C@@H](C)C7)cc6F)cn5)CC4)c3)c2)C(C)(C)C)cc1]

To a solution of 2-(3′-(2-(((S)-1-((2S,4R)-4-hydroxy-2-((((S)-1-(4-(4-methylthiazol-5-yl)phenyl)ethyl)amino)methyl)pyrrolidin-1-yl)-3,3-dimethyl-1-oxobutan-2-yl)amino)-2-oxoethyl)-[1,1′-biphenyl]-3-yl)acetic acid (160 mg, 229.60 μmol) in CH₂Cl₂ (5 mL) was added dropwise HOAt (5.21 mg, 38.27 μmol), NMM (96.77 mg, 956.68 μmol, 105.18 μL) and EDCI (44.02 mg, 229.60 μmol) at 0° C. After addition, the mixture was stirred at this temperature for 30 min, and then 4-fluoro-N-(4-fluoro-5-(2-(piperazin-1-yl)pyrimidin-5-yl)-2-((3R,5S)-3,4,5-trimethylpiperazin-1-yl)phenyl)-2-(trifluoromethyl)benzamide (112.81 mg, 180.19 μmol, HCl) was added dropwise at 0° C. The resulting mixture was stirred at 25° C. for 1.5 hours. The reaction mixture was concentrated in vacuo. The crude product was purified by prep-HPLC (FA; column: Phenomenex luna C18 150*25 mm*10 um; mobile phase: [water(FA)-ACN]; gradient: 30%-60% B over 10 min) to give (2S,4R)-1-[(2S)-2-[[2-[3-[3-[2-[4-[5-[2-fluoro-5-[[4-fluoro-2-(trifluoromethyl)benzoyl]amino]-4-[(3R,5S)-3,4,5-trimethylpiperazin-1-yl]phenyl]pyrimidin-2-yl]piperazin-1-yl]-2-oxo-ethyl]phenyl]phenyl]acetyl]amino]-3,3-dimethyl-butanoyl]-4-hydroxy-N-[(1S)-1-[4-(4-methylthiazol-5-yl)phenyl]ethyl]pyrrolidine-2-carboxamide (50.29 mg, 39.21 μmol, 20.49% yield, 98.9% purity) as an off-white solid. ¹H NMR: MeOD-d₄, 400 MHz. δ 8.88-8.83 (m, 1H), 8.54-8.50 (m, 2H), 8.00 (d, J=8.4 Hz, 1H), 7.79-7.71 (m, 1H), 7.65-7.62 (m, 1H), 7.60-7.50 (m, 5H), 7.47-7.35 (m, 6H), 7.32-7.28 (m, 2H), 7.09 (d, J=12.0 Hz, 1H), 5.03-4.95 (m, 1H), 4.64-4.60 (m, 1H), 4.58-4.53 (m, 2H), 4.42-4.35 (m, 1H), 3.94 (s, 2H), 3.90-3.83 (m, 3H), 3.77-3.66 (m, 8H), 3.06 (d, J=11.2 Hz, 2H), 2.68-2.50 (m, 4H), 2.47-2.44 (m, 3H), 2.38 (s, 3H), 2.21-2.11 (m, 1H), 2.00-1.88 (m 1H), 1.49 (d, J=7.2 Hz, 3H), 1.17 (d, J=6.0 Hz, 6H), 1.02-0.97 (m, 9H). LCMS: RT=1.921 min, m/z 1268.6 [M+H]⁺.

### Example B-14. Synthesis of (2S,4R)-1-((S)-2-(2-(4′-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)-[1,1′-biphenyl]-4-yl)acetamido)-3,3-dimethylbutanoyl)-4-hydroxy-N—((S)-1-(4-(4-methylthiazol-5-yl)phenyl)ethyl)pyrrolidine-2-carboxamide

The title compound was prepared using general procedures described for (2S,4R)-1-[(2S)-2-[[2-[3-[3-[2-[4-[5-[2-fluoro-5-[[4-fluoro-2-(trifluoromethyl)benzoyl]amino]-4-[(3R,5S)-3,4,5-trimethylpiperazin-1-yl]phenyl]pyrimidin-2-yl]piperazin-1-yl]-2-oxo-ethyl]phenyl]phenyl]acetyl]amino]-3,3-dimethyl-butanoyl]-4-hydroxy-N-[(1S)-1-[4-(4-methylthiazol-5-yl)phenyl]ethyl]pyrrolidine-2-carboxamide. ¹H NMR: DMSO-d₆, 400 MHz. δ 9.71 (s, 1H), 8.98 (s, 1H), 8.53 (s, 2H), 8.39 (d, J=7.6 Hz, 1H), 8.15-8.05 (m, 1H), 7.84-7.70 (m, 4H), 7.69-7.64 (m, 4H), 7.46-7.41 (m, 2H), 7.39-7.33 (m, 6H), 7.14-7.05 (m, 1H), 5.09 (d, J=3.6 Hz, 1H), 4.97-4.87 (m, 1H), 4.53-4.49 (m, 1H), 4.44 (t, J=8.4 Hz, 1H), 4.32-4.19 (m, 1H), 3.89-3.73 (m, 7H), 3.71-3.54 (m, 8H), 3.53-3.46 (m, 1H), 3.13-3.00 (m, 2H), 2.46-4.43 (m, 6H), 2.28-2.20 (m, 2H), 2.05-1.97 (m, 1H), 1.84-1.74 (m, 1H), 1.38 (d, J=7.2 Hz, 3H), 1.10-1.00 (m, 6H), 0.93 (s, 9H). LCMS: RT=1.937 min, m/z 1268.8 [M+H]f.

### Example B-15. Synthesis of (2S,4R)-1-((S)-2-(2-(4′-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)-[1,1′-biphenyl]-3-yl)acetamido)-3,3-dimethylbutanoyl)-4-hydroxy-N—((S)-1-(4-(4-methylthiazol-5-yl)phenyl)ethyl)pyrrolidine-2-carboxamide

The title compound was prepared using general procedures described for (2S,4R)-1-[(2S)-2-[[2-[3-[3-[2-[4-[5-[2-fluoro-5-[[4-fluoro-2-(trifluoromethyl)benzoyl]amino]-4-[(3R,5S)-3,4,5-trimethylpiperazin-1-yl]phenyl]pyrimidin-2-yl]piperazin-1-yl]-2-oxo-ethyl]phenyl]phenyl]acetyl]amino]-3,3-dimethyl-butanoyl]-4-hydroxy-N-[(1S)-1-[4-(4-methylthiazol-5-yl)phenyl]ethyl]pyrrolidine-2-carboxamide. ¹H NMR: 400 MHz. δ 8.88-8.84 (m, 1H), 8.54-8.52 (m, 2H), 8.01 (d, J=8.4 Hz, 1H), 7.80-7.73 (m, 1H), 7.68-7.61 (m, 3H), 7.60-7.50 (m, 3H), 7.44-7.34 (m, 7H), 7.30-7.25 (m, 1H), 7.11 (d, J=12.0 Hz, 1H), 5.02-4.94 (m, 1H), 4.64-4.60 (m, 1H), 4.59-4.51 (m, 2H), 4.43-4.34 (m, 1H), 3.93-3.81 (m, 5H), 3.78-3.66 (m, 8H), 3.15-3.07 (m, 2H), 2.79-2.62 (m, 4H), 2.51-2.44 (m, 6H), 2.21-2.11 (m, 1H), 1.99-1.88 (m, 1H), 1.52-1.41 (m, 3H), 1.25-1.18 (m, 6H), 1.03-0.96 (m, 9H). LCMS: RT=1.921 min, m/z 1268.6 [M+H]⁺.

### Example B-16. Synthesis of (2S,4R)-1-((S)-2-(2-(3′-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)-[1,1′-biphenyl]-4-yl)acetamido)-3,3-dimethylbutanoyl)-4-hydroxy-N—((S)-1-(4-(4-methylthiazol-5-yl)phenyl)ethyl)pyrrolidine-2-carboxamide

The title compound was prepared using general procedures described for (2S,4R)-1-[(2S)-2-[[2-[3-[3-[2-[4-[5-[2-fluoro-5-[[4-fluoro-2-(trifluoromethyl)benzoyl]amino]-4-[(3R,5S)-3,4,5-trimethylpiperazin-1-yl]phenyl]pyrimidin-2-yl]piperazin-1-yl]-2-oxo-ethyl]phenyl]phenyl]acetyl]amino]-3,3-dimethyl-butanoyl]-4-hydroxy-N-[(1S)-1-[4-(4-methylthiazol-5-yl)phenyl]ethyl]pyrrolidine-2-carboxamide. ¹H NMR: DMSO-d₆, 400 MHz. δ 9.69 (s, 1H), 8.98 (s, 1H), 8.53 (s, 2H), 8.39 (d, J=7.6 Hz, 1H), 8.23-8.06 (m, 1H), 7.82-7.70 (m, 4H), 7.59-7.50 (m, 4H), 7.45-7.41 (m, 2H), 7.40-7.35 (m, 5H), 7.27-7.22 (m, 1H), 7.07 (d, J=12.0 Hz, 1H), 5.16-5.04 (m, 1H), 4.96-4.87 (m, 1H), 4.51 (d, J=9.2 Hz, 1H), 4.44 (t, J=8.4 Hz, 1H), 4.31-4.23 (m, 1H), 3.89-3.82 (m, 2H), 3.80-3.74 (m, 4H), 3.72-3.58 (m, 8H), 3.53-3.47 (m, 2H), 3.06-3.00 (m, 2H), 2.47-2.45 (m, 5H), 2.17 (s, 3H), 2.05-1.96 (m, 1H), 1.83-1.73 (m, 1H), 1.38 (d, J=6.8 Hz, 3H), 1.01 (d, J=6.0 Hz, 6H), 0.95-0.90 (m, 9H). LCMS: RT=1.918 min, m/z 1268.6 [M+H]⁺.

### Example B-17. Synthesis of (2S,4R)-1-((S)-2-(2-(9-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)-3,9-diazaspiro[5.5]undecan-3-yl)acetamido)-3,3-dimethylbutanoyl)-4-hydroxy-N—((S)-1-(4-(4-methylthiazol-5-yl)phenyl)ethyl)pyrrolidine-2-carboxamide

The title compound was prepared using general procedures described for (2S,4R)-1-((S)-2-(2-(4-((1-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)piperidin-4-yl)methyl)piperazin-1-yl)acetamido)-3,3-dimethylbutanoyl)-4-hydroxy-N—((S)-1-(4-(4-methylthiazol-5-yl)phenyl)ethyl)pyrrolidine-2-carboxamide. ¹H NMR: CD₃OD-d₄, 400 MHz. δ 8.87 (s, 1H), 8.57 (s, 2H), 8.05-7.98 (m, 1H), 7.81-7.73 (m, 1H), 7.68-7.61 (m, 1H), 7.60-7.53 (m, 1H), 7.47-7.35 (m, 4H), 7.14-7.06 (m, 1H), 5.04-4.97 (m, 1H), 4.66-4.34 (m, 4H), 3.99-3.82 (m, 5H), 3.78-3.62 (m, 5H), 3.37-3.32 (m, 2H), 3.09-3.01 (m, 4H), 2.65-2.57 (m, 3H), 2.56-2.50 (m, 6H), 2.48-2.41 (m, 5H), 2.33 (s, 3H), 2.25-2.16 (m, 1H), 2.04-1.90 (m, 1H), 1.65-1.47 (m, 11H), 1.17-1.12 (m, 6H), 1.07-1.00 (m, 9H). LCMS: RT=1.169 min, m/z 1268.6 [M+H]⁺.

### Example B-18. Synthesis of (2S,4R)-1-((S)-2-(2-(4-((1-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)piperidin-4-yl)methyl)piperazin-1-yl)acetamido)-3,3-dimethylbutanoyl)-4-hydroxy-N—((S)-1-(4-(4-methylthiazol-5-yl)phenyl)ethyl)pyrrolidine-2-carboxamide

### A. Step 1

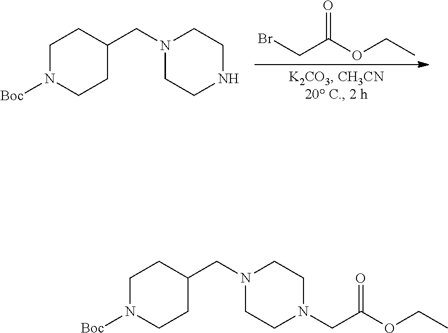

To a solution of tert-butyl 4-(piperazin-1-ylmethyl)piperidine-1-carboxylate (0.8 g, 2.82 mmol), K₂CO₃ (800.00 mg, 5.79 mmol) in CH₃CN (15 mL) was added ethyl 2-bromoacetate (560.00 mg, 3.35 mmol, 371.11 μL) at 20° C. The reaction mixture was stirred at 20° C. for 2 hours. Ethyl acetate (30 mL) and water (40 mL) were added and layers were separated. The aqueous phase was extracted with Ethyl acetate (30 mL*2). Combined organic layer was washed with brine (30 mL), dried over anhydrous Na₂SO₄, filtered, and concentrated in vauco. Tert-butyl 4-((4-(2-ethoxy-2-oxoethyl)piperazin-1-yl)methyl)piperidine-1-carboxylate (1 g, 2.71 mmol, 95.88% yield) was obtained as a yellow oil. LCMS: RT=0.473 min, m/z 370.3 [M+H]⁺. ¹H NMR: CDCl₃, 400 MHz. δ 4.19 (q, J=7.2 Hz, 2H), 4.11-4.01 (m, 2H), 3.20 (s, 2H), 2.75-2.43 (m, 10H), 2.19 (d, J=7.2 Hz, 2H), 1.73-1.70 (m, 2H), 1.67-1.59 (m, 1H), 1.45 (s, 9H), 1.30-1.25 (m, 3H), 1.10-1.01 (m, 2H).

### B. Step 2

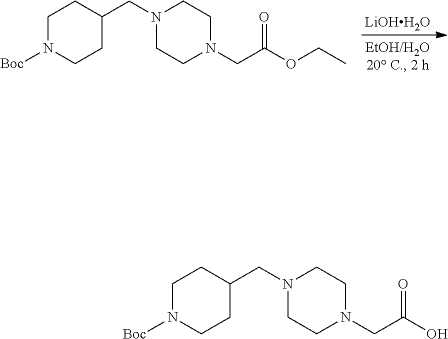 [SMILES: CCOC(=O)CN1CCN(CC2CCN(C(=O)OC(C)(C)C)CC2)CC1 ; "LiOH·H2O" ; CC(C)(C)OC(=O)N1CCC(CN2CCN(CC(=O)O)CC2)CC1]

To a solution of tert-butyl 4-((4-(2-ethoxy-2-oxoethyl)piperazin-1-yl)methyl)piperidine-1-carboxylate (1 g, 2.71 mmol) in EtOH (10 mL)/H₂O (2 mL) was added LiOH—H₂O (227.14 mg, 5.41 mmol) at 20° C. The mixture was stirred at 20° C. for 2 hours. The solvent was removed in vauco. The aqueous phase was adjusted to pH=4-5 by addition of HCl (2 M). The aqueous phase was concentrated in vauco. The residue was purified by prep-HPLC (column: Phenomenex Luna C18 150*25 mm*10 um; mobile phase: [water(FA)-ACN]; gradient: 1%-31% B over 9 min). 2-(4-((1-(tert-butoxycarbonyl)piperidin-4-yl)methyl)piperazin-1-yl)acetic acid (0.65 g, 1.90 mmol, 70.34% yield) was obtained as a white solid. LCMS: RT=0.424 min, m/z 342.2 [M+H]⁺. ¹H NMR: DMSO-d₆, 400 MHz. δ 3.95-3.80 (m, 2H), 3.18 (s, 2H), 2.83-2.58 (m, 7H), 2.47-2.40 (m, 3H), 2.18-2.10 (m 2H), 1.71-1.60 (m, 3H), 1.38 (s, 9H), 0.98-0.84 (m, 2H).

### C. Step 3

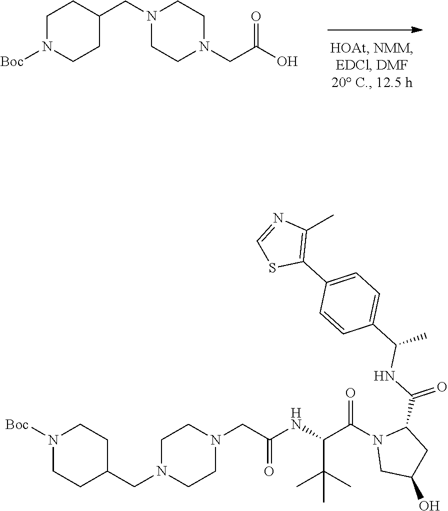 [SMILES: CC(C)(C)OC(=O)N1CCC(CN2CCN(CC(=O)O)CC2)CC1 ; Cc1ncsc1-c1ccc([C@H](C)NC(=O)[C@@H]2C[C@@H](O)CN2C(=O)[C@@H](NC(=O)CN2CCN(CC3CCN(C(=O)OC(C)(C)C)CC3)CC2)C(C)(C)C)cc1]

To a solution of 2-(4-((1-(tert-butoxycarbonyl)piperidin-4-yl)methyl)piperazin-1-yl)acetic acid (300 mg, 878.62 μmol), NMM (266.61 mg, 2.64 mmol, 289.79 μL), HOAt (179.38 mg, 1.32 mmol) in DMF (8 mL) was added EDCI (252.65 mg, 1.32 mmol) at 20° C. and the mixture was stirred for 30 minutes. Then to this solution was added (2S,4R)-1-((S)-2-amino-3,3-dimethylbutanoyl)-4-hydroxy-N—((S)-1-(4-(4-methylthiazol-5-yl)phenyl)ethyl)pyrrolidine-2-carboxamide (390.62 mg, 878.62 μmol) and the resulting mixture was stirred at 20° C. for 12 hours. Ethyl acetate (20 mL) and water (20 mL) were added and layers were separated. The aqueous phase was extracted with Ethyl acetate (30 mL*2). Combined organic layer was washed with brine (60 mL), dried over Na₂SO₄, filtered, and concentrated in vauco. The residue was purified by prep-HPLC (column: Phenomenex luna C18 150*25 mm*10 um; mobile phase: [water(FA)-ACN]; gradient: 15%-45% B over 10 min). Compound tert-butyl 4-((4-(2-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)amino)-2-oxoethyl)piperazin-1-yl)methyl)piperidine-1-carboxylate (420 mg, 546.86 μmol, 62.24% yield) was obtained as a yellow solid. LCMS: RT=0.519 min, m/z 768.6 [M+H]⁺. ¹H NMR: MeOD-d₃, 400 MHz. δ 8.88 (s, 1H), 8.33 (s, 1H), 7.49-7.34 (m, 4H), 5.08-4.96 (m, 1H), 4.64 (s, 1H), 4.59-4.52 (m, 1H), 4.46-4.36 (m, 1H), 4.11-4.08 (m, 2H), 3.89-3.48 (m, 2H), 3.26-3.15 (m, 2H), 3.14-2.94 (m, 4H), 2.92-2.66 (m, 8H), 2.52-2.44 (m, 3H), 2.40-2.19 (m, 1H), 2.05-1.86 (m, 2H), 1.82-1.71 (m, 2H), 1.59-1.50 (m, 3H), 1.45 (s, 9H), 1.21-1.09 (m, 2H), 1.08-0.97 (m, 9H).

### D. Step 4

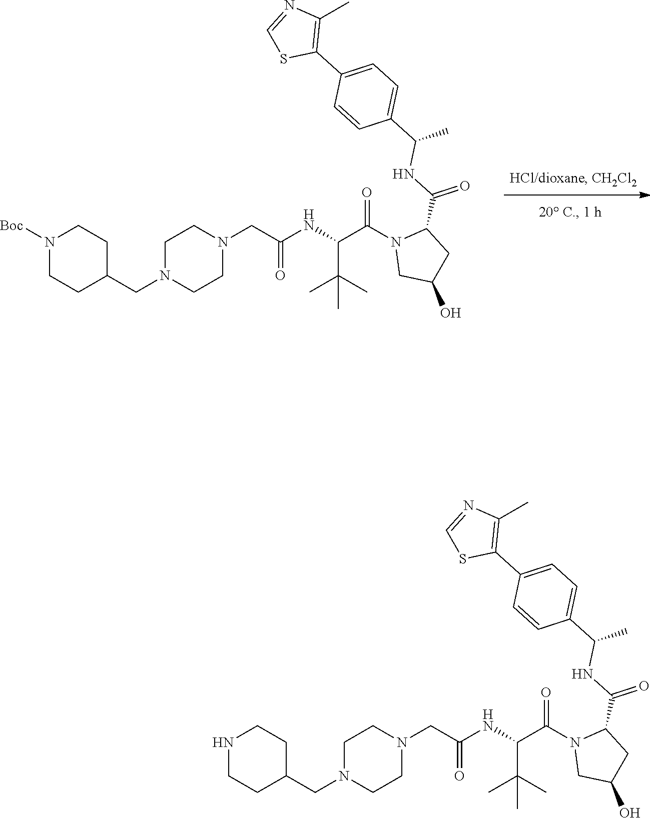 [SMILES: Cc1ncsc1-c1ccc([C@H](C)NC(=O)[C@@H]2C[C@@H](O)CN2C(=O)[C@@H](NC(=O)CN2CCN(CC3CCN(C(=O)OC(C)(C)C)CC3)CC2)C(C)(C)C)cc1 ; Cc1ncsc1-c1ccc([C@H](C)NC(=O)[C@@H]2C[C@@H](O)CN2C(=O)[C@@H](NC(=O)CN2CCN(CC3CCNCC3)CC2)C(C)(C)C)cc1]

To a solution of tert-butyl 4-((4-(2-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)amino)-2-oxoethyl)piperazin-1-yl)methyl)piperidine-1-carboxylate (420 mg, 546.86 μmol) in CH₂Cl₂ (5 mL) was added HCl/dioxane (4 M, 2 mL) at 20° C. The mixture was stirred at 20° C. for 1 hour. The solvent was removed in vacuo. Compound (2S,4R)-1-((S)-3,3-dimethyl-2-(2-(4-(piperidin-4-ylmethyl)piperazin-1-yl)acetamido)butanoyl)-4-hydroxy-N—((S)-1-(4-(4-methylthiazol-5-yl)phenyl)ethyl)pyrrolidine-2-carboxamide (400 mg, crude, HCl) was obtained as yellow oil. LCMS: RT=0.445 min, m/z 668.4 [M+H]⁺.

### E. Step 5

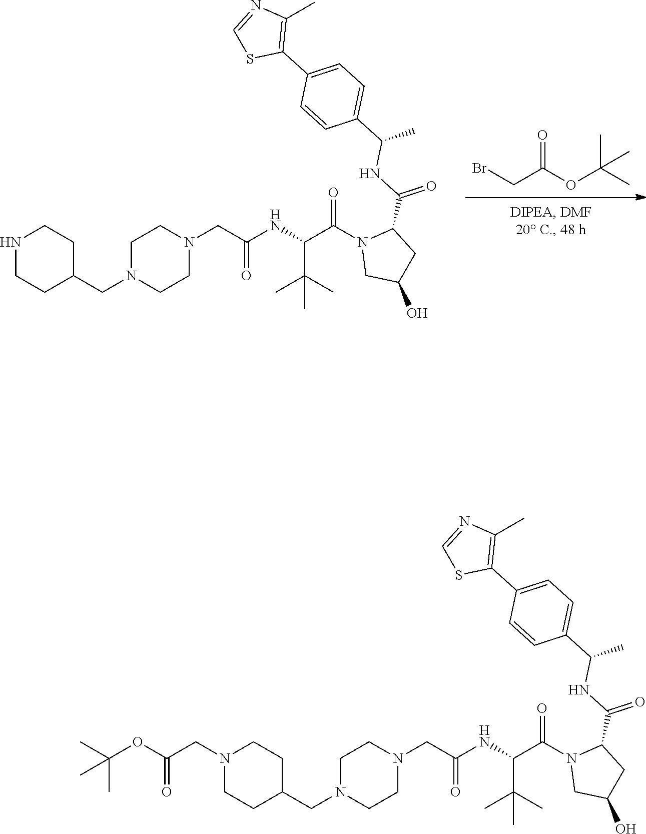

To a solution of (2S,4R)-1-((S)-3,3-dimethyl-2-(2-(4-(piperidin-4-ylmethyl)piperazin-1-yl)acetamido)butanoyl)-4-hydroxy-N—((S)-1-(4-(4-methylthiazol-5-yl)phenyl)ethyl)pyrrolidine-2-carboxamide (180 mg, 255.55 μmol, HCl), tert-butyl 2-bromoacetate (55 mg, 281.97 μmol) in DMF (5 mL) was added DIPEA (74.20 mg, 574.11 μmol) at 20° C. and stirred for 48 hours. The reaction mixture was diluted with H₂O (30 mL). The aqueous phase was extracted with Ethyl acetate (20 mL*5). The combined organic layer was washed with brine (20 mL), dried over Na₂SO₄, filtered, and concentrated in vacuo. Compound tert-butyl 2-(4-((4-(2-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)amino)-2-oxoethyl)piperazin-1-yl)methyl)piperidin-1-yl)acetate (0.19 g, 242.95 μmol, 95.07% yield) was obtained as colorless oil. LCMS: RT=0.490 min, m/z 782.6 [M+H]⁺.

### F. Step 6

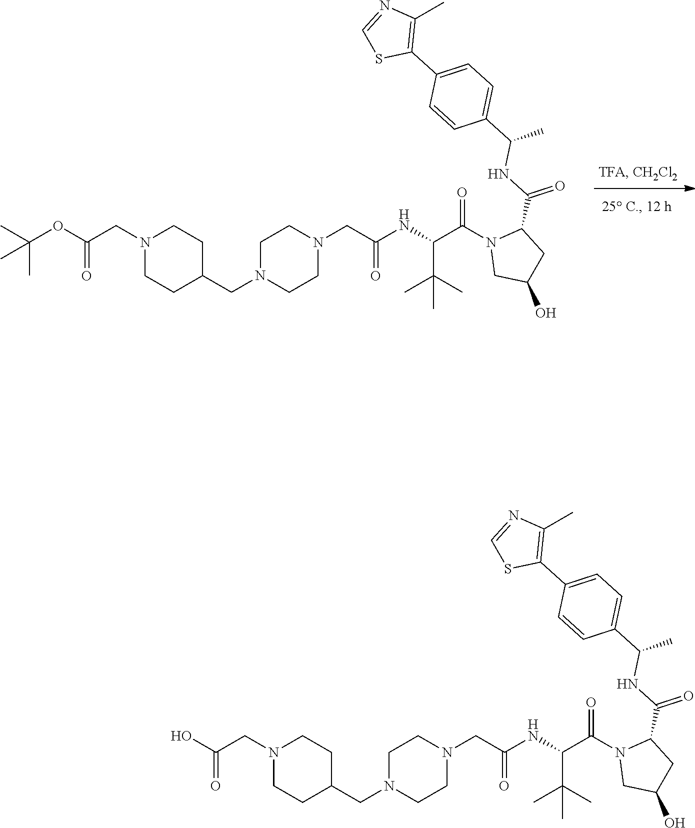 [SMILES: Cc1ncsc1-c1ccc([C@H](C)NC(=O)[C@@H]2C[C@@H](O)CN2C(=O)[C@@H](NC(=O)CN2CCN(CC3CCN(CC(=O)OC(C)(C)C)CC3)CC2)C(C)(C)C)cc1 ; Cc1ncsc1-c1ccc([C@H](C)NC(=O)[C@@H]2C[C@@H](O)CN2C(=O)[C@@H](NC(=O)CN2CCN(CC3CCN(CC(=O)O)CC3)CC2)C(C)(C)C)cc1]

To a solution of tert-butyl 2-(4-((4-(2-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)amino)-2-oxoethyl)piperazin-1-yl)methyl)piperidin-1-yl)acetate (0.19 g, 242.95 μmol) in CH₂Cl₂ (5 mL) was added TFA (1.54 g, 13.46 mmol, 1 mL) at 25° C. and stirred for 12 hours. The solvent was removed in vacuo. The residue was purified by prep-HPLC (column: Waters Xbridge C18 150*50 mm*10 um; mobile phase: [water(NH₄HCO₃)-ACN]; gradient: 10%-40% B over 10 min). Compound 2-(4-((4-(2-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)amino)-2-oxoethyl)piperazin-1-yl)methyl)piperidin-1-yl)acetic acid (150 mg, 206.63 μmol, 85.05% yield) was obtained as a white solid. LCMS: RT=0.467 min, m/z 726.6 [M+H]⁺.

### G. Step 7

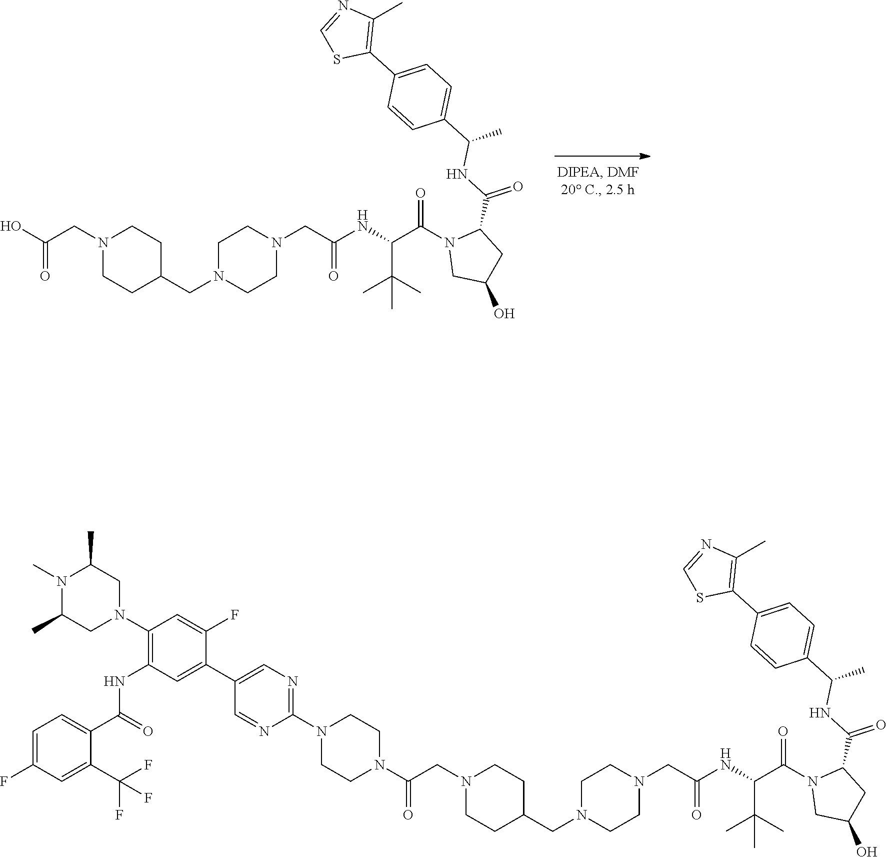 [SMILES: Cc1ncsc1-c1ccc([C@H](C)NC(=O)[C@@H]2C[C@@H](O)CN2C(=O)[C@@H](NC(=O)CN2CCN(CC3CCN(CC(=O)O)CC3)CC2)C(C)(C)C)cc1 ; Cc1ncsc1-c1ccc([C@H](C)NC(=O)[C@@H]2C[C@@H](O)CN2C(=O)[C@@H](NC(=O)CN2CCN(CC3CCN(CC(=O)N4CCN(c5ncc(-c6cc(NC(=O)c7ccc(F)cc7C(F)(F)F)c(N7C[C@@H](C)N(C)[C@@H](C)C7)cc6F)cn5)CC4)CC3)CC2)C(C)(C)C)cc1]

To a solution of 2-(4-((4-(2-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)amino)-2-oxoethyl)piperazin-1-yl)methyl)piperidin-1-yl)acetic acid (150 mg, 206.63 μmol), NMM (62.70 mg, 619.89 μmol), HOAt (33.75 mg, 247.95 μmol) in CH₂CL₂ (5 mL) was added EDCI (79.22 mg, 413.26 μmol) at 20° C., the reaction mixture was stirred for 0.5 hours. To the solution was added 4-fluoro-N-(4-fluoro-5-(2-(piperazin-1-yl)pyrimidin-5-yl)-2-((3R,5S)-3,4,5-trimethylpiperazin-1-yl)phenyl)-2-(trifluoromethyl)benzamide (116.43 mg, 185.97 μmol, HCl) and stirred at 20° C. for 2 hours. The reaction mixture was concentrated in vacuo. The residue was purified by prep-HPLC (column: Phenomenex luna C18 150*25 mm*10 um; mobile phase: [water(FA)-ACN]; gradient: 7%-37% B over 10 min). Compound (2S,4R)-1-((S)-2-(2-(4-((1-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)piperidin-4-yl)methyl)piperazin-1-yl)acetamido)-3,3-dimethylbutanoyl)-4-hydroxy-N—((S)-1-(4-(4-methylthiazol-5-yl)phenyl)ethyl)pyrrolidine-2-carboxamide (125.75 mg, 94.77 μmol, 45.87% yield, 97.79% purity) was obtained as a white solid. ¹H NMR: CD₃OD-d₄, 400 MHz. δ 8.87 (s, 1H), 8.58 (s, 2H), 8.03 (d, J=7.6 Hz, 1H), 7.80-7.73 (m, 1H), 7.67-7.63 (m, 1H), 7.59-7.54 (m, 1H), 7.47-7.35 (m, 4H), 7.14 (d, J=11.8 Hz, 1H), 5.04-4.98 (m, 1H), 4.81-4.75 (m, 1H), 4.66-4.48 (m, 2H), 4.44 (s, 1H), 4.02-3.79 (m, 7H), 3.78-3.60 (m, 5H), 3.33 (br s, 1H), 3.18-3.12 (m, 2H), 3.11-3.01 (m, 2H), 2.93-2.52 (m, 17H), 2.48 (s, 3H), 2.39 (br d, J=5.8 Hz, 2H), 2.25-2.17 (m, 1H), 2.03-1.90 (m, 3H), 1.86-1.76 (m, 1H), 1.60-1.51 (m, 3H), 1.50-1.44 (m, 2H), 1.29-1.22 (m, 6H), 1.08-0.99 (m, 9H). LCMS: RT=1.169 min, m/z 1297.6 [M+H]⁺.

### Example B-19. Synthesis of (2S,4R)-1-((S)-2-(2-(4-((4-(3-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-3-oxopropyl)piperazin-1-yl)methyl)piperidin-1-yl)acetamido)-3,3-dimethylbutanoyl)-4-hydroxy-N—((S)-1-(4-(4-methylthiazol-5-yl)phenyl)ethyl)pyrrolidine-2-carboxamide

The title compound was prepared using general procedures described for (2S,4R)-1-((S)-2-(2-(4-((1-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)piperidin-4-yl)methyl)piperazin-1-yl)acetamido)-3,3-dimethylbutanoyl)-4-hydroxy-N—((S)-1-(4-(4-methylthiazol-5-yl)phenyl)ethyl)pyrrolidine-2-carboxamide. ¹H NMR: MeOD-d₄, 400 MHz. δ 8.87 (s, 1H), 8.58 (d, J=1.2 Hz, 2H), 8.02 (d, J=8.4 Hz, 1H), 7.79-7.72 (m 1H), 7.66-7.63 (m, 1H), 7.60-7.53 (m, 1H), 7.47-7.36 (m, 4H), 7.10 (d, J=12.0 Hz, 1H), 5.08-4.96 (m, 1H), 4.67-4.47 (m, 411), 4.45-4.40 (m, 11H), 4.02-3.82 (m, 5H), 3.77-3.61 (m, 5H), 3.29-3.19 (m, 2H), 3.11-2.97 (m, 6H), 2.85-2.75 (m 2H), 2.64-2.46 (m, 15H), 2.34 (s, 3H), 2.32-2.25 (m, 2H), 2.23-2.18 (m, 1H), 2.00-1.86 (m, 3H), 1.81-1.66 (m, 1H), 1.59-1.49 (m, 3H), 1.43-1.28 (m, 2H), 1.16 (d, J=6.4 Hz, 6H), 1.08-0.98 (m, 9H). LCMS: RT=1.178 min, m/z 1311.6 [M+H]⁺.

### Example B-20. Synthesis of (2S,4R)-1-((S)-2-(3-(4-((1-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)piperidin-4-yl)methyl)piperazin-1-yl)propanamido)-3,3-dimethylbutanoyl)-4-hydroxy-N—((S)-1-(4-(4-methylthiazol-5-yl)phenyl)ethyl)pyrrolidine-2-carboxamide

The title compound was prepared using general procedures described for (2S,4R)-1-((S)-2-(2-(4-((1-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)piperidin-4-yl)methyl)piperazin-1-yl)acetamido)-3,3-dimethylbutanoyl)-4-hydroxy-N—((S)-1-(4-(4-methylthiazol-5-yl)phenyl)ethyl)pyrrolidine-2-carboxamide. ¹H NMR: MeOD-d₄, 400 MHz. δ 8.90-8.86 (m, 1H), 8.59 (s, 2H), 8.04 (d, J=8.4 Hz, 1H), 7.83-7.75 (m, 1H), 7.69-7.63 (m, 1H), 7.61-7.53 (m, 1H), 7.48-7.37 (m, 4H), 7.17 (d, J=12.0 Hz, 1H), 5.06-4.97 (m, 1H), 4.97-4.91 (m, 1H), 4.64-4.53 (m, 4H), 4.47-4.38 (m, 1H), 4.00-3.87 (m, 6H), 3.86-3.69 (m, 4H), 3.65-3.59 (m, 2H), 3.58-3.45 (m, 1H), 3.44-3.34 (m, 2H), 3.25-3.17 (m, 2H), 3.15-3.00 (m, 2H), 2.93-2.71 (m, 12H), 2.68 (s, 3H), 2.54-2.49 (m, 2H), 2.49-2.47 (m, 3H), 2.47-2.45 (m, 1H), 2.27-2.15 (m, 1H), 2.05-1.76 (m, 4H), 1.58 (d, J=7.6 Hz, 1H), 1.52 (d, J=7.2 Hz, 3H), 1.49-1.42 (m, 1H), 1.34-1.28 (m, 6H), 1.10-1.02 (m, 9H). LCMS: ONB-1087466-8_001_LCMS_EW39718-312, RT=1.167 min, m/z 1311.8 [M+H]⁺.

### Example B-21. Synthesis of (2S,4S)-1-((S)-2-(10-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-10-oxodecanamido)-3,3-dimethylbutanoyl)-4-hydroxy-N-(4-(4-methylthiazol-5-yl)benzyl)pyrrolidine-2-carboxamide

The title compound was prepared using general procedures described for (2S,4R)-1-((S)-2-(10-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-10-oxodecanamido)-3,3-dimethylbutanoyl)-4-hydroxy-N—((S)-1-(4-(4-methylthiazol-5-yl)phenyl)ethyl)pyrrolidine-2-carboxamide HNMR: MeOD-d₄, 400 MHz. δ 8.87 (s, 1H), 8.57-8.54 (m, 2H), 8.01 (d, J=8.4 Hz, 1H), 7.79-7.73 (m, 1H), 7.67-7.62 (m, 1H), 7.59-7.52 (m, 1H), 7.46-7.39 (m, 4H), 7.09 (d, J=12.0 Hz, 1H), 4.57-4.49 (m, 3H), 4.42-4.34 (m, 2H), 4.08-4.00 (m, 1H), 3.94-3.84 (m, 4H), 3.73-3.63 (m, 5H), 3.07-3.02 (m, 2H), 2.66-2.60 (m, 2H), 2.49-2.41 (m, 8H), 2.32 (s, 3H), 2.30-2.21 (m, 2H), 2.03-1.94 (m, 1H), 1.66-1.56 (m, 4H), 1.30-1.27 (m, 8H), 1.17-1.12 (m, 6H), 1.03 (s, 9H). LCMS: RT=1.906 min, m/z 1186.6 [M+H]⁺.

### Example B-22. Synthesis of (2S,4S)-1-((S)-2-(3-(2-(3-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-3-oxopropoxy)ethoxy)propanamido)-3,3-dimethylbutanoyl)-4-hydroxy-N-(4-(4-methylthiazol-5-yl)benzyl)pyrrolidine-2-carboxamide

The title compound was prepared using general procedures described for (2S,4R)-1-((S)-2-(10-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-10-oxodecanamido)-3,3-dimethylbutanoyl)-4-hydroxy-N—((S)-1-(4-(4-methylthiazol-5-yl)phenyl)ethyl)pyrrolidine-2-carboxamide. ¹H NMR: CDCl₃, 400 MHz. δ 8.68 (s, 1H), 8.61-8.51 (m, 4H), 8.05-7.88 (m, 1H), 7.71-7.61 (m, 1H), 7.55-7.46 (m, 1H), 7.44-7.34 (m, 5H), 7.14-6.98 (m, 2H), 5.75-5.64 (m, 1H), 4.76-4.63 (m, 2H), 4.58-4.52 (m, 1H), 4.50-4.42 (m, 1H), 4.34-4.26 (m, 1H), 3.95-3.80 (m, 8H), 3.79-3.46 (m, 11H), 2.91-2.81 (m, 2H), 2.74-2.61 (m, 3H), 2.53-2.51 (m, 3H), 2.50-2.46 (m, 2H), 2.44-2.27 (m, 4H), 2.26-2.15 (m, 2H), 1.38-1.06 (m, 6H), 0.96 (s, 9H). LCMS: RT=1.598 min, m/z 1190.6 [M+H]⁺.

### Example B-23. Synthesis of (2S,4R)-1-((S)-2-(4-(4-((2-(4-(2-fluoro-5-(4-fluoro-2-(trifluoromethyl)benzamido)-4-((3R,5S)-3,4,5-trimethylpiperazin-1-yl)phenyl)-3,6-dihydropyridin-1(2H)-yl)pyrimidin-5-yl)methyl)piperazin-1-yl)-4-oxobutanamido)-3,3-dimethylbutanoyl)-4-hydroxy-N-(4-(4-methylthiazol-5-yl)benzyl)pyrrolidine-2-carboxamide

### A. Step 1

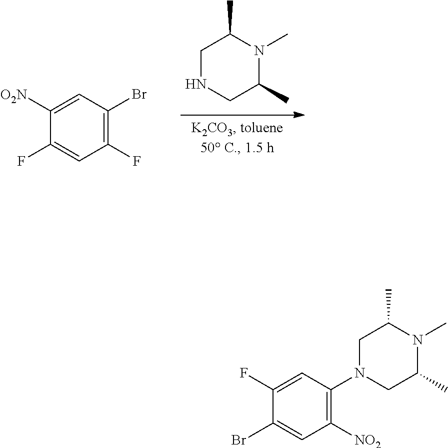

To a solution of 1-bromo-2,4-difluoro-5-nitrobenzene (20 g, 84.04 mmol) in toluene (200 mL) was added K₂CO₃ (23.23 g, 168.08 mmol) at 50° C. for 30 min, and then (2S,6R)-1,2,6-trimethylpiperazine (10.77 g, 84.04 mmol) was added. The resulting mixture was stirred at 50° C. for 1 hour. LCMS showed the desired mass. After the reaction mixture was cooled to 0° C. The reaction mixture was filtered through a pad of celite. The filtrate was concentrated in vacuo. The residue was purified by flash silica gel chromatography (ISCO®; 120 g SepaFlash® Silica Flash Column, Eluent of 0˜50% Ethylacetate/Petroleum ether gradient @100 mL/min) to give (2R,6S)-4-(4-bromo-5-fluoro-2-nitrophenyl)-1,2,6-trimethylpiperazine (25 g, 72.21 mmol, 85.93% yield) as a yellow solid. LCMS: RT=0.452 min, m/z 346.0 [M+H]⁺.

### B. Step 2

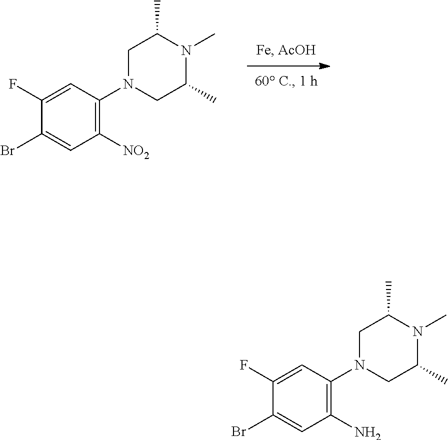 [SMILES: C[C@@H]1CN(c2cc(F)c(Br)cc2[N+](=O)[O-])C[C@H](C)N1C ; C[C@@H]1CN(c2cc(F)c(Br)cc2N)C[C@H](C)N1C]

To a solution of (2R,6S)-4-(4-bromo-5-fluoro-2-nitrophenyl)-1,2,6-trimethylpiperazine (25 g, 72.21 mmol) in AcOH (120 mL) was added Fe (24.20 g, 433.28 mmol). The resulting mixture was stirred at 60° C. for 1 hour. LCMS showed the desired mass. After cooling to room temperature (25° C.), the mixture was adjusted pH to 9-12 with NaOH aqueous solution. The mixture was diluted with methanol (100 mL) and H₂O (100 mL). Layers were separated. The aqueous phase was extracted with ethyl acetate (100 mL×3). The combined organic layer was washed with brine (100 mL×3), dried over anhydrous Na₂SO₄, filtered, and concentrated in vacuo. The residue was purified by flash silica gel chromatography (ISCO®; 40 g SepaFlash® Silica Flash Column, Eluent of 0-100% Ethyl acetate/Petroleum ethergradient @100 mL/min) to give 5-bromo-4-fluoro-2-((3R,5S)-3,4,5-trimethylpiperazin-1-yl)aniline (18 g, 56.92 mmol, 78.83% yield) as a yellow solid. LCMS: RT=0.427 min, m/z 316.1 [M+H]⁺.

### C. Step 3

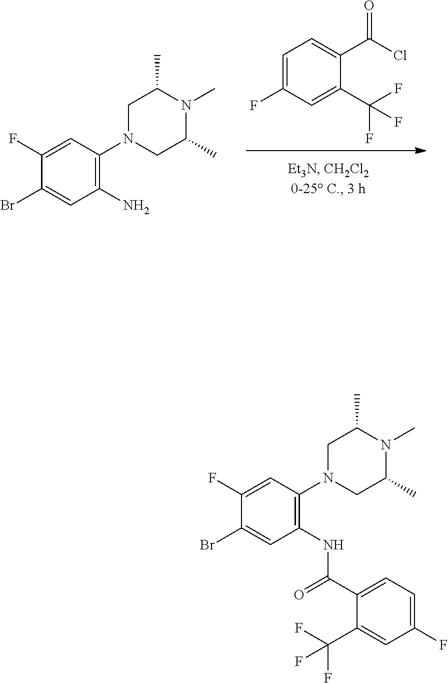

To a solution of 4-fluoro-2-(trifluoromethyl)benzoyl chloride (10.75 g, 47.44 mmol, 7.19 mL) in CH₂Cl₂ (100 mL) was added Et3N (9.60 g, 94.87 mmol, 13.21 mL) and 5-bromo-4-fluoro-2-((3R,5S)-3,4,5-trimethylpiperazin-1-yl)aniline (10 g, 31.62 mmol) at 0° C. The resulting mixture was stirred at 25° C. for 3 hours. The mixture was concentrated. The mixture was diluted with H₂O (100 mL) and extracted with ethyl acetate (100 mL×3). The combined organic layer was washed with brine (100 mL×3), dried over anhydrous Na₂SO₄, filtered, and concentrated in vacuo. The crude product was triturated with (Petroleum ether/Ethyl acetate=5/1) (50 mL) at 25° C. for 30 min to give N-(5-bromo-4-fluoro-2-((3R,5S)-3,4,5-trimethylpiperazin-1-yl)phenyl)-4-fluoro-2-(trifluoromethyl)benzamide (15.8 g, 31.21 mmol, 98.68% yield) as a white solid. LCMS: RT=0.506 min, m/z 508.1 [M+1+H]*.

### D. Step 4

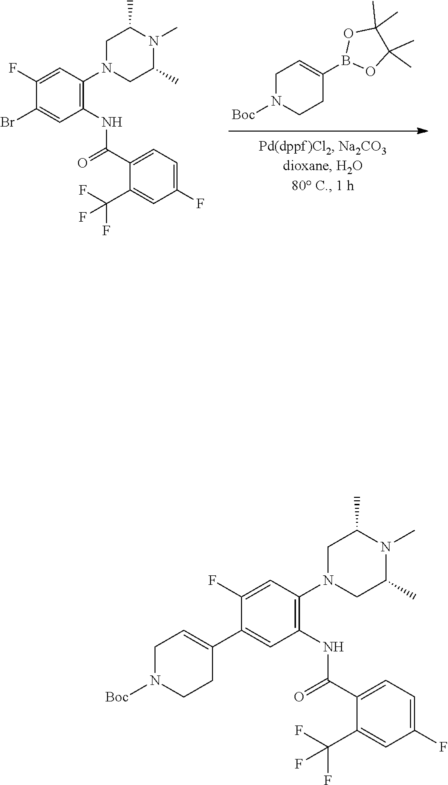 [SMILES: C[C@@H]1CN(c2cc(F)c(Br)cc2NC(=O)c2ccc(F)cc2C(F)(F)F)C[C@H](C)N1C ; CC(C)(C)OC(=O)N1CC=C(B2OC(C)(C)C(C)(C)O2)CC1 ; C[C@@H]1CN(c2cc(F)c(C3=CCN(C(=O)OC(C)(C)C)CC3)cc2NC(=O)c2ccc(F)cc2C(F)(F)F)C[C@H](C)N1C]

A mixture of N-(5-bromo-4-fluoro-2-((3R,5S)-3,4,5-trimethylpiperazin-1-yl)phenyl)-4-fluoro-2-(trifluoromethyl)benzamide (7 g, 13.83 mmol), tert-butyl 4-(4,4,5,5-tetramethyl-1,3,2-dioxaborolan-2-yl)-3,6-dihydropyridine-1(2H)-carboxylate (6.41 g, 20.74 mmol), Na₂CO₃ (2.93 g, 27.65 mmol) and Pd(dppf)Cl₂ (1.01 g, 1.38 mmol) in dioxane (70 mL)/H₂O (14 mL) was degassed and purged with N₂ for 3 times, and then the mixture was stirred at 80° C. for 1 hour under N₂ atmosphere. After the reaction mixture was cooled to 25° C., the mixture was diluted with H₂O (100 mL) and extracted with ethyl acetate (100 mL×3). The combined organic layer was washed with brine (100 mL×3), dried over anhydrous Na₂SO₄, filtered, and concentrated in vacuo. The residue was purified by flash silica gel chromatography (ISCO®; 80 g SepaFlash® Silica Flash Column, Eluent of 0-100% Ethyl acetate/Petroleum ethergradient @100 mL/min) to give tert-butyl 4-(2-fluoro-5-(4-fluoro-2-(trifluoromethyl)benzamido)-4-((3R,5S)-3,4,5-trimethylpiperazin-1-yl)phenyl)-3,6-dihydropyridine-1(2H)-carboxylate (8.3 g, 13.64 mmol, 98.64% yield) as a brown solid. LCMS: RT=0.549 min, m/z 609.8 [M+H]⁺.

### E. Step 5

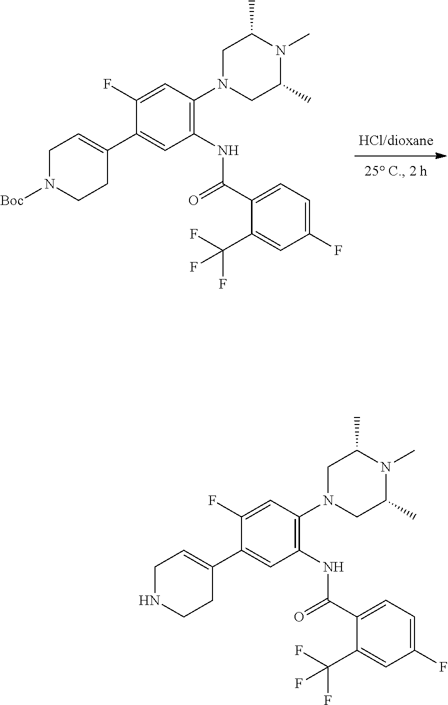 [SMILES: C[C@@H]1CN(c2cc(F)c(C3=CCN(C(=O)OC(C)(C)C)CC3)cc2NC(=O)c2ccc(F)cc2C(F)(F)F)C[C@H](C)N1C ; C[C@@H]1CN(c2cc(F)c(C3=CCNCC3)cc2NC(=O)c2ccc(F)cc2C(F)(F)F)C[C@H](C)N1C]

To a solution of tert-butyl 4-(2-fluoro-5-(4-fluoro-2-(trifluoromethyl)benzamido)-4-((3R,5S)-3,4,5-trimethylpiperazin-1-yl)phenyl)-3,6-dihydropyridine-1(2H)-carboxylate (8.3 g, 13.64 mmol) in CH₂Cl₂ (80 mL) was added HCl/dioxane (4 M, 80 mL). The resulting mixture was stirred at 25° C. for 2 hours. The reaction mixture was poured into 100 mL of water and the solid was washed with ethyl acetate (100 mL×3). The aqueous phase was basified to pH=8-9 with sat.NaHCO₃ solution. The aqueous phase was extracted with CH₂Cl₂/MeOH (10:1, 100 mL×3). The combined organic layer was washed with brine (100 mL×3), dried over anhydrous Na₂SO₄, filtered, and concentrated in vacuo to give 4-fluoro-N-(4-fluoro-5-(1,2,3,6-tetrahydropyridin-4-yl)-2-((3R,5S)-3,4,5-trimethylpiperazin-1-yl)phenyl)-2-(trifluoromethyl)benzamide (5.7 g, 11.21 mmol, 82.19% yield) as a brown solid. ¹H NMR: DMSO-d₆, 400 MHz. δ 9.55 (brs, 1H), 7.83-7.62 (m, 4H), 7.00-6.84 (m, 1H), 5.94 (brs, 1H), 3.48-3.42 (m, 2H), 3.01-2.94 (m, 2H), 2.93-2.87 (m, 2H), 2.47-2.38 (m, 2H), 2.35-2.23 (m, 4H), 2.15 (s, 3H), 1.07-0.92 (m, 6H). LCMS: RT=0.398 min, m/z 509.4 [M+H]⁺.

### F. Step 6

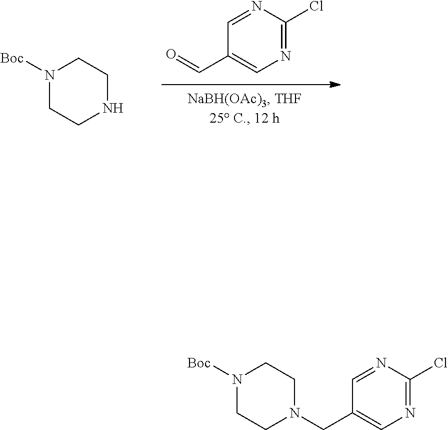 [SMILES: CC(C)(C)OC(=O)N1CCNCC1 ; O=Cc1cnc(Cl)nc1 ; CC(C)(C)OC(=O)N1CCN(Cc2cnc(Cl)nc2)CC1]

To a solution of tert-butyl piperazine-1-carboxylate (6.53 g, 35.08 mmol) and 2-chloropyrimidine-5-carbaldehyde (5 g, 35.08 mmol) in THF (150 mL) was added NaBH(OAc)₃ (11.15 g, 52.62 mmol). The reaction was stirred at 25° C. for 12 hours. The reaction mixture was filtered. The filtrated was concentrated in vacuo. The residue was purified by prep-HPLC (column: Waters Xbridge BEH C18 250*50 mm*10 um; mobile phase: [water(FA)-ACN]; gradient: 7%-37% B over 20 min) to give the desired product tert-butyl 4-((2-chloropyrimidin-5-yl)methyl)piperazine-1-carboxylate (4.7 g, 15.03 mmol, 42.84% yield) as a white solid. ¹H NMR: CDCl₃, 400 MHz. δ 8.59 (s, 2H), 3.52 (s, 2H), 3.48-3.40 (m, 4H), 2.49-2.34 (m, 4H), 1.46 (s, 9H). LCMS: RT=0.409 min, m/z 313.1 [M+H]⁺.

### G. Step 7

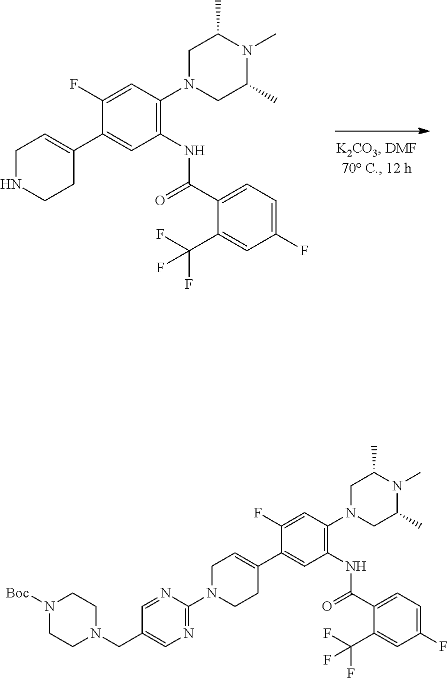 [SMILES: C[C@@H]1CN(c2cc(F)c(C3=CCNCC3)cc2NC(=O)c2ccc(F)cc2C(F)(F)F)C[C@H](C)N1C ; C[C@@H]1CN(c2cc(F)c(C3=CCN(c4ncc(CN5CCN(C(=O)OC(C)(C)C)CC5)cn4)CC3)cc2NC(=O)c2ccc(F)cc2C(F)(F)F)C[C@H](C)N1C]

To a solution of 4-fluoro-N-(4-fluoro-5-(1,2,3,6-tetrahydropyridin-4-yl)-2-((3R,5S)-3,4,5-trimethylpiperazin-1-yl)phenyl)-2-(trifluoromethyl)benzamide (750 mg, 1.47 mmol) and tert-butyl 4-((2-chloropyrimidin-5-yl)methyl)piperazine-1-carboxylate (691.99 mg, 2.21 mmol) in DMF (10 mL) was added K₂CO₃ (611.50 mg, 4.42 mmol). The resulting mixture was stirred at 70° C. for 12 hours. The mixture was diluted with H₂O (20 mL) and extracted with ethyl acetate (20 mL×3). The combined organic layers were washed with brine (30 mL×3), dried over anhydrous Na₂SO₄, filtered, and concentrated in vacuo. The residue was purified by flash silica gel chromatography (ISCO®; 20 g SepaFlash® Silica Flash Column, Eluent of 0-100% Ethylacetate/Petroleum ethergradient @60 mL/min) to tert-butyl 4-((2-(4-(2-fluoro-5-(4-fluoro-2-(trifluoromethyl)benzamido)-4-((3R,5S)-3,4,5-trimethylpiperazin-1-yl)phenyl)-3,6-dihydropyridin-1(2H)-yl)pyrimidin-5-yl)methyl)piperazine-1-carboxylate (950 mg, 1.21 mmol, 82.07% yield) as a yellow oil. ¹H NMR: CDCl₃, 400 MHz. δ 8.46 (s, 1H), 8.38-8.31 (m, 1H), 8.25-8.16 (m, 2H), 7.61-7.54 (m, 1H), 7.45-7.38 (m, 1H), 7.34-7.26 (m, 1H), 6.82 (d, J=11.6 Hz, 1H), 6.05 (s, 1H), 4.36-4.28 (m, 2H), 4.03-3.94 (m, 2H), 3.38-3.32 (m, 4H), 3.31-3.26 (m, 2H), 2.75-2.68 (m, 2H), 2.60-2.49 (m, 4H), 2.39-2.28 (m, 4H), 2.22-2.13 (m, 5H), 1.38 (s, 9H), 1.05-0.99 (m, 6H). LCMS: RT=0.472 min, m/z 785.6 [M+H]⁺.

### H. Step 8

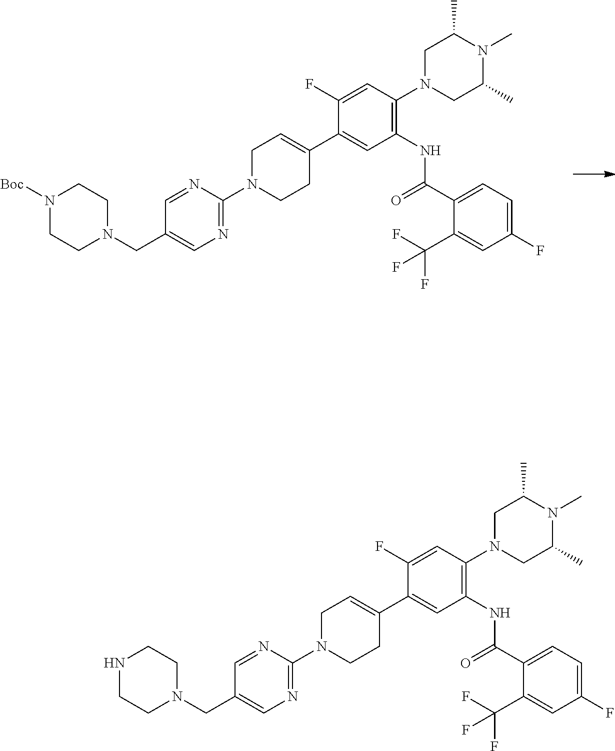 [SMILES: C[C@@H]1CN(c2cc(F)c(C3=CCN(c4ncc(CN5CCN(C(=O)OC(C)(C)C)CC5)cn4)CC3)cc2NC(=O)c2ccc(F)cc2C(F)(F)F)C[C@H](C)N1C ; C[C@@H]1CN(c2cc(F)c(C3=CCN(c4ncc(CN5CCNCC5)cn4)CC3)cc2NC(=O)c2ccc(F)cc2C(F)(F)F)C[C@H](C)N1C]

To a solution of tert-butyl 4-((2-(4-(2-fluoro-5-(4-fluoro-2-(trifluoromethyl)benzamido)-4-((3R,5S)-3,4,5-trimethylpiperazin-1-yl)phenyl)-3,6-dihydropyridin-1(2H)-yl)pyrimidin-5-yl)methyl)piperazine-1-carboxylate (950 mg, 1.21 mmol) in CH₂Cl₂ (10 mL) was added HCl/dioxane (4 M, 6.69 mL). The resulting mixture was stirred at 25° C. for 0.5 hour. The mixture was concentrated in vacuo to give the desired product 4-fluoro-N-(4-fluoro-5-(1-(5-(piperazin-1-ylmethyl)pyrimidin-2-yl)-1,2,3,6-tetrahydropyridin-4-yl)-2-((3R,5S)-3,4,5-trimethylpiperazin-1-yl)phenyl)-2-(trifluoromethyl)benzamide (1.1 g, crude, HCl) as a yellow solid. LCMS: RT=0.414 min, m/z 685.4 [M+H]⁺.

### I. Step 9

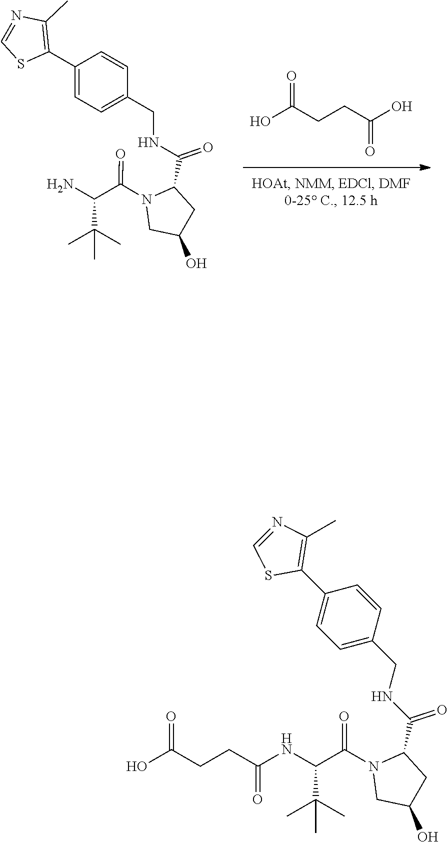 [SMILES: Cc1ncsc1-c1ccc(CNC(=O)[C@@H]2C[C@@H](O)CN2C(=O)[C@@H](N)C(C)(C)C)cc1 ; O=C(O)CCC(=O)O ; Cc1ncsc1-c1ccc(CNC(=O)[C@@H]2C[C@@H](O)CN2C(=O)[C@@H](NC(=O)CCC(=O)O)C(C)(C)C)cc1]

To a solution of succinic acid (548.53 mg, 4.65 mmol) in DMF (5 mL) and CH₂Cl₂ (10 mL) was added NMM (1.17 g, 11.61 mmol, 1.28 mL), EDCI (534.28 mg, 2.79 mmol) and HOAt (63.22 mg, 464.51 μmol). Then the mixture was cooled to 0° C. (2S,4R)-1-((S)-2-amino-3,3-dimethylbutanoyl)-4-hydroxy-N-(4-(4-methylthiazol-5-yl)benzyl)pyrrolidine-2-carboxamide (1 g, 2.32 mmol) was added. The mixture was stirred at 25° C. for 12 hours. The reaction mixture was concentrated in vacuo. The crude product was purified by prep-HPLC (FA: column: Phenomenex luna C18 150*40 mm*15 um; mobile phase: [water(FA)-ACN]; gradient: 22%-52% B over 15 min) to give 4-(((S)-1-((2S,4R)-4-hydroxy-2-((4-(4-methylthiazol-5-yl)benzyl)carbamoyl)pyrrolidin-1-yl)-3,3-dimethyl-1-oxobutan-2-yl)amino)-4-oxobutanoic acid (710 mg, 1.33 mmol, 57.15% yield, 99.21% purity) as a white solid. ¹H NMR: CDCl₃, 400 MHz. δ 8.71 (s, 1H), 7.70 (s, 1H), 7.37-7.31 (m, 4H), 7.23-7.15 (m, 1H), 4.67-4.56 (m, 3H), 4.50 (s, 1H), 4.35-4.27 (m, 1H), 4.12-4.04 (m, 1H), 3.71-3.66 (m, 1H), 2.76-2.59 (m, 2H), 2.53-2.46 (m, 5H), 2.32-2.19 (m, 2H), 0.97 (s, 9H). LCMS: RT=0.445 min, m/z 531.2 [M+H]⁺.

### J. Step 10

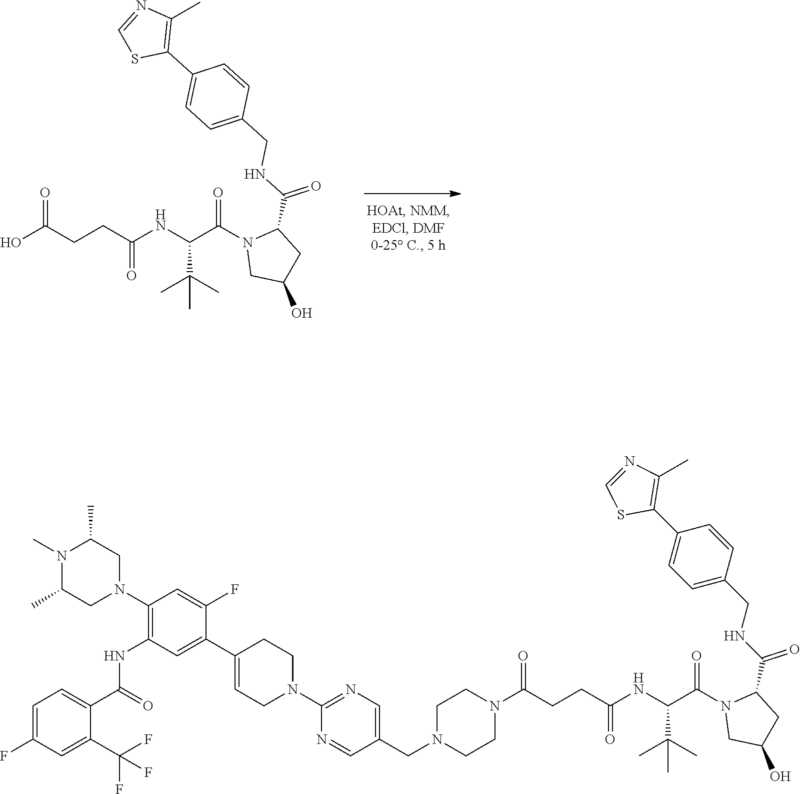 [SMILES: Cc1ncsc1-c1ccc(CNC(=O)[C@@H]2C[C@@H](O)CN2C(=O)[C@@H](NC(=O)CCC(=O)O)C(C)(C)C)cc1 ; Cc1ncsc1-c1ccc(CNC(=O)[C@@H]2C[C@@H](O)CN2C(=O)[C@@H](NC(=O)CCC(=O)N2CCN(Cc3cnc(N4CC=C(c5cc(NC(=O)c6ccc(F)cc6C(F)(F)F)c(N6C[C@@H](C)N(C)[C@@H](C)C6)cc5F)CC4)nc3)CC2)C(C)(C)C)cc1]

To a solution of 4-(((S)-1-((2S,4R)-4-hydroxy-2-((4-(4-methylthiazol-5-yl)benzyl)carbamoyl)pyrrolidin-1-yl)-3,3-dimethyl-1-oxobutan-2-yl)amino)-4-oxobutanoic acid (80 mg, 150.76 μmol) in DMF (2 mL) was added HOAt (3.42 mg, 25.13 μmol), NMM (63.54 mg, 628.18 μmol, 69.06 μL) and EDCI (28.90 mg, 150.76 μmol) at 0° C. Then 4-fluoro-N-(4-fluoro-5-(1-(5-(piperazin-1-ylmethyl)pyrimidin-2-yl)-1,2,3,6-tetrahydropyridin-4-yl)-2-((3R,5S)-3,4,5-trimethylpiperazin-1-yl)phenyl)-2-(trifluoromethyl)benzamide (90.61 mg, 125.64 μmol, HCl) was added. The mixture was stirred at 25° C. for 5 hours. The reaction mixture was concentrated in vacuo. The crude product was purified by prep-HPLC (FA; column: Phenomenex luna C18 150*25 mm*10 um; mobile phase: [water(FA)-ACN]; gradient: 14%-44% B over 10 min) to give (2S,4R)-1-((S)-2-(4-(4-((2-(4-(2-fluoro-5-(4-fluoro-2-(trifluoromethyl)benzamido)-4-((3R,5S)-3,4,5-trimethylpiperazin-1-yl)phenyl)-3,6-dihydropyridin-1(2H)-yl)pyrimidin-5-yl)methyl)piperazin-1-yl)-4-oxobutanamido)-3,3-dimethylbutanoyl)-4-hydroxy-N-(4-(4-methylthiazol-5-yl)benzyl)pyrrolidine-2-carboxamide (82.24 mg, 65.33 μmol, 52.00% yield, 95.11% purity) as a yellow solid. HNMR: METHANOL-d₄, 400 MHz. δ 8.87 (s, 1H), 8.32 (s, 2H), 7.92-7.85 (m, 2H), 7.79-7.72 (m, 1H), 7.66-7.62 (m, 1H), 7.58-7.52 (m, 1H), 7.48-7.44 (m, 2H), 7.43-7.39 (m, 2H), 7.01 (d, J=12.0 Hz, 1H), 6.13 (s, 1H), 4.61-4.57 (m, 2H), 4.56-4.51 (m, 2H), 4.50-4.47 (m, 1H), 4.39-4.33 (m, 3H), 4.10-4.03 (m, 2H), 3.91-3.85 (m, 1H), 3.81-3.75 (m, 1H), 3.61-3.52 (m, 4H), 3.44 (s, 2H), 3.18-3.10 (m, 2H), 2.96-2.91 (m, 2H), 2.78-2.72 (m, 2H), 2.70-2.63 (m, 2H), 2.61 (s, 3H), 2.60-2.57 (m, 2H), 2.56-2.48 (m, 3H), 2.47 (s, 3H), 2.46-2.40 (m, 2H), 2.25-2.17 (m, 1H), 2.11-2.03 (m, 1H), 1.28-1.24 (m, 6H), 1.02 (s, 9H). LCMS: RT=1.314 min, m/z 1197.6 [M+H]⁺.

### Example B-24. Synthesis of (2S,4R)-1-((S)-2-(5-(4-((2-(4-(2-fluoro-5-(4-fluoro-2-(trifluoromethyl)benzamido)-4-((3R,5S)-3,4,5-trimethylpiperazin-1-yl)phenyl)-3,6-dihydropyridin-1(2H)-yl)pyrimidin-5-yl)methyl)piperazin-1-yl)-5-oxopentanamido)-3,3-dimethylbutanoyl)-4-hydroxy-N-(4-(4-methylthiazol-5-yl)benzyl)pyrrolidine-2-carboxamide

The title compound was prepared using general procedures described for (2S,4R)-1-((S)-2-(4-(4-((2-(4-(2-fluoro-5-(4-fluoro-2-(trifluoromethyl)benzamido)-4-((3R,5S)-3,4,5-trimethylpiperazin-1-yl)phenyl)-3,6-dihydropyridin-1(2H)-yl)pyrimidin-5-yl)methyl)piperazin-1-yl)-4-oxobutanamido)-3,3-dimethylbutanoyl)-4-hydroxy-N-(4-(4-methylthiazol-5-yl)benzyl)pyrrolidine-2-carboxamide. ¹H NMR: CDCl₃, 400 MHz. δ 8.69 (s, 1H), 8.44 (d, J=8.0 Hz, 1H), 8.31-8.27 (m, 2H), 8.21 (s, 1H), 7.70-7.63 (m, 1H), 7.54-7.46 (m, 2H), 7.43-7.30 (m, 6H), 6.98 (d, J=11.6 Hz, 1H), 6.86 (d, J=8.4 Hz, 1H), 6.12 (brs, 1H), 4.75-4.68 (m, 1H), 4.62-4.54 (m, 1H), 4.53-4.45 (m, 2H), 4.40-4.31 (m, 3H), 4.18-4.10 (m, 1H), 4.10-4.01 (m, 2H), 3.64-3.56 (m, 3H), 3.49-3.43 (m, 2H), 3.41 (s, 2H), 2.99-2.90 (m, 3H), 2.86-2.82 (m, 2H), 2.69-2.59 (m, 4H), 2.52 (s, 3H), 2.49 (s, 3H), 2.47-2.44 (m, 3H), 2.40-2.12 (m, 6H), 1.96-1.85 (m, 2H), 1.27-1.22 (m, 6H), 0.95 (s, 9H). LCMS: RT=0.820 min, m/z 1211.7 [M+H]⁺.

### Example B-25. Synthesis of (2S,4R)-1-((S)-2-(6-(4-((2-(4-(2-fluoro-5-(4-fluoro-2-(trifluoromethyl)benzamido)-4-((3R,5S)-3,4,5-trimethylpiperazin-1-yl)phenyl)-3,6-dihydropyridin-1(2H)-yl)pyrimidin-5-yl)methyl)piperazin-1-yl)-6-oxohexanamido)-3,3-dimethylbutanoyl)-4-hydroxy-n-(4-(4-methylthiazol-5-yl)benzyl)pyrrolidine-2-carboxamide

The title compound was prepared using general procedures described for (2S,4R)-1-((S)-2-(4-(4-((2-(4-(2-fluoro-5-(4-fluoro-2-(trifluoromethyl)benzamido)-4-((3R,5S)-3,4,5-trimethylpiperazin-1-yl)phenyl)-3,6-dihydropyridin-1(2H)-yl)pyrimidin-5-yl)methyl)piperazin-1-yl)-4-oxobutanamido)-3,3-dimethylbutanoyl)-4-hydroxy-N-(4-(4-methylthiazol-5-yl)benzyl)pyrrolidine-2-carboxamide. ¹H NMR: MeOD-d₄, 400 MHz. δ 8.87 (s, 1H), 8.34-8.32 (m, 2H), 7.95-7.82 (m, 2H), 7.80-7.72 (m, 1H), 7.67-7.63 (m, 1H), 7.60-7.52 (m, 1H), 7.49-7.44 (m, 2H), 7.43-7.39 (m, 2H), 7.04 (d, J=12.4 Hz, 1H), 6.12 (brs, 1H), 4.64-4.48 (m, 5H), 4.39-4.33 (m, 3H), 4.09-4.02 (m, 2H), 3.93-3.86 (m, 1H), 3.83-3.76 (m, 1H), 3.61-3.53 (m, 4H), 3.46-3.40 (m, 2H), 3.25-3.16 (m, 4H), 2.87-2.80 (m, 2H), 2.76 (s, 3H), 2.62-2.56 (m, 2H), 2.53-2.48 (m, 2H), 2.49 (s, 3H), 2.46-2.44 (m, 1H), 2.42-2.37 (m, 2H), 2.34-2.36 (m, 2H), 2.24-2.17 (m, 1H), 2.13-2.02 (m, 1H), 1.68-1.58 (m, 4H), 1.36-1.32 (m, 6H), 1.03 (s, 9H). LCMS: RT=1.334 min, m/z 1225.6 [M+H]⁺.

### Example B-26. Synthesis of (2S,4R)-1-((S)-2-(7-(4-((2-(4-(2-fluoro-5-(4-fluoro-2-(trifluoromethyl)benzamido)-4-((3R,5S)-3,4,5-trimethylpiperazin-1-yl)phenyl)-3,6-dihydropyridin-1(2H)-yl)pyrimidin-5-yl)methyl)piperazin-1-yl)-7-oxoheptanamido)-3,3-dimethylbutanoyl)-4-hydroxy-N-(4-(4-methylthiazol-5-yl)benzyl)pyrrolidine-2-carboxamide

The title compound was prepared using general procedures described for (2S,4R)-1-((S)-2-(4-(4-((2-(4-(2-fluoro-5-(4-fluoro-2-(trifluoromethyl)benzamido)-4-((3R,5S)-3,4,5-trimethylpiperazin-1-yl)phenyl)-3,6-dihydropyridin-1(2H)-yl)pyrimidin-5-yl)methyl)piperazin-1-yl)-4-oxobutanamido)-3,3-dimethylbutanoyl)-4-hydroxy-N-(4-(4-methylthiazol-5-yl)benzyl)pyrrolidine-2-carboxamide. ¹H NMR: MeOD-d₄, 400 MHz. δ 8.87 (s, 1H), 8.38 (s, 1H), 8.33-8.26 (m, 2H), 7.91 (d, J=8.4 Hz, 1H), 7.85-7.72 (m, 2H), 7.69-7.62 (m, 1H), 7.60-7.51 (m, 1H), 7.50-7.37 (m, 4H), 7.03 (d, J=12.0 Hz, 1H), 6.23-6.07 (m, 1H), 4.64-4.50 (m, 4H), 4.41-4.30 (m, 3H), 4.13-3.99 (m, 2H), 3.95-3.86 (m, 1H), 3.83-3.76 (m, 1H), 3.65-3.52 (m, 4H), 3.48-3.37 (m, 2H), 3.24-3.15 (m, 2H), 3.15-3.04 (m, 2H), 2.88-2.75 (m, 2H), 2.70 (s, 3H), 2.64-2.55 (m, 2H), 2.53-2.42 (m, 7H), 2.40-2.34 (m, 2H), 2.33-2.25 (m, 2H), 2.24-2.17 (m, 1H), 2.15-2.02 (m, 1H), 1.69-1.55 (m, 4H), 1.42-1.34 (m, 2H), 1.33-2.29 (m, 6H), 1.03 (s, 9H). LCMS: RT=1.389 min, m/z 1239.6 [M+H]⁺.

### Example B-27. Synthesis of (2S,4R)-1-((S)-2-(8-(4-((2-(4-(2-fluoro-5-(4-fluoro-2-(trifluoromethyl)benzamido)-4-((3R,5S)-3,4,5-trimethylpiperazin-1-yl)phenyl)-3,6-dihydropyridin-1(2H)-yl)pyrimidin-5-yl)methyl)piperazin-1-yl)-8-oxoheptanamido)-3,3-dimethylbutanoyl)-4-hydroxy-N-(4-(4-methylthiazol-5-yl)benzyl)pyrrolidine-2-carboxamide

The title compound was prepared using general procedures described for (2S,4R)-1-((S)-2-(4-(4-((2-(4-(2-fluoro-5-(4-fluoro-2-(trifluoromethyl)benzamido)-4-((3R,5S)-3,4,5-trimethylpiperazin-1-yl)phenyl)-3,6-dihydropyridin-1(2H)-yl)pyrimidin-5-yl)methyl)piperazin-1-yl)-4-oxobutanamido)-3,3-dimethylbutanoyl)-4-hydroxy-N-(4-(4-methylthiazol-5-yl)benzyl)pyrrolidine-2-carboxamide. ¹H NMR: CDCl₃, 400 MHz. δ 8.68 (s, 1H), 8.54-8.48 (m, 1H), 8.45 (d, J=7.6 Hz, 1H), 8.27-8.24 (m, 2H), 7.69-7.64 (m, 1H), 7.52-7.47 (m, 1H), 7.43-7.33 (m, 7H), 6.99-6.94 (m, 1H), 6.23 (d, J=9.2 Hz, 1H), 6.15-6.10 (m, 1H), 4.79-4.72 (m, 2H), 4.63-4.58 (m, 1H), 4.58-4.52 (m, 3H), 4.41-4.36 (m, 3H), 4.36-4.27 (m, 1H), 4.17-4.10 (m, 1H), 4.08-4.02 (m, 2H), 3.62-3.56 (m, 3H), 3.47-3.42 (m, 2H), 3.38-3.32 (m, 2H), 2.87-2.83 (m, 2H), 2.65-2.61 (m, 2H), 2.52 (s, 3H), 2.49-2.38 (m, 8H), 2.33-2.25 (m, 3H), 2.25-2.12 (m, 4H), 1.58-1.52 (m, 3H), 1.33-1.23 (m, 10H), 0.94 (s, 9H). LCMS: RT=1.421 min, m/z 1253.6 [M+H]⁺.

### Example B-28. Synthesis of (2S,4R)-1-((S)-2-(9-(4-((2-(4-(2-fluoro-5-(4-fluoro-2-(trifluoromethyl)benzamido)-4-((3R,5S)-3,4,5-trimethylpiperazin-1-yl)phenyl)-3,6-dihydropyridin-1(2H)-yl)pyrimidin-5-yl)methyl)piperazin-1-yl)-9-oxononanamido)-3,3-dimethylbutanoyl)-4-hydroxy-N-(4-(4-methylthiazol-5-yl)benzyl)pyrrolidine-2-carboxamide

The title compound was prepared using general procedures described for (2S,4R)-1-((S)-2-(4-(4-((2-(4-(2-fluoro-5-(4-fluoro-2-(trifluoromethyl)benzamido)-4-((3R,5S)-3,4,5-trimethylpiperazin-1-yl)phenyl)-3,6-dihydropyridin-1(2H)-yl)pyrimidin-5-yl)methyl)piperazin-1-yl)-4-oxobutanamido)-3,3-dimethylbutanoyl)-4-hydroxy-N-(4-(4-methylthiazol-5-yl)benzyl)pyrrolidine-2-carboxamide. ¹H NMR: MeOD-d₄, 400 MHz. δ 8.87 (s, 1H), 8.41 (s, 1H), 8.34-8.29 (m, 2H), 7.90 (d, J=8.0 Hz, 1H), 7.82-7.72 (m, 2H), 7.68-7.62 (m, 1H), 7.60-7.52 (m, 1H), 7.48-7.38 (m, 4H), 7.01 (d, J=11.6 Hz, 1H), 6.19-6.09 (m, 1H), 4.63-4.53 (m, 8H), 4.40-4.32 (m, 3H), 4.05 (m, 2H), 3.94-3.87 (m, 1H), 3.84-3.76 (m, 1H), 3.63-3.50 (m, 4H), 3.45-3.40 (m, 2H), 3.19-3.12 (m, 2H), 3.04-2.88 (m, 2H), 2.81-2.69 (m, 2H), 2.65-2.61 (m, 3H), 2.60-2.56 (m, 2H), 2.47-2.46 (m, 3H), 2.43-2.37 (m, 2H), 2.30-2.23 (m, 2H), 2.22-2.17 (m, 1H), 2.14-2.04 (m, 1H), 1.65-1.54 (m, 4H), 1.37-1.32 (m, 6H), 1.30-1.26 (m, 6H), 1.03 (s, 9H). LCMS: RT=1.465 min, m/z 1267.8 [M+H]⁺.

### Example B-29. Synthesis of (2S,4R)-1-[(2S)-2-[[2-[3-[2-[4-[5-[2-fluoro-5-[[4-fluoro-2-(trifluoromethyl)benzoyl]amino]-4-[(3R,5S)-3,4,5-trimethylpiperazin-1-yl]phenyl]pyrimidin-2-yl]piperazin-1-yl]-2-oxo-ethoxy]propoxy]acetyl]amino]-3,3-dimethyl-butanoyl]-4-hydroxy-N-[[4-(4-methylthiazol-5-yl)phenyl]methyl]pyrrolidine-2-carboxamide

The title compound was prepared using general procedures described for (2S,4R)-1-((S)-2-(10-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-10-oxodecanamido)-3,3-dimethylbutanoyl)-4-hydroxy-N—((S)-1-(4-(4-methylthiazol-5-yl)phenyl)ethyl)pyrrolidine-2-carboxamide. ¹H NMR: DMSO-d₆, 400 MHz. δ 9.69 (s, 1H), 8.96 (s, 1H), 8.63-8.50 (m, 3H), 7.85-7.66 (m, 4H), 7.45-7.34 (m, 5H), 7.07 (d, J=12.4 Hz, 1H), 5.21-5.05 (m, 1H), 4.55 (d, J=9.6 Hz, 1H), 4.46-4.23 (m, 4H), 4.18 (s, 2H), 3.94-3.92 (m, 2H), 3.84-3.75 (m, 4H), 3.68-3.51 (m, 10H), 3.03-3.01 (m, 2H), 2.48-2.41 (m, 5H), 2.34-2.27 (m, 2H), 2.17 (s, 3H), 2.09-2.01 (m, 1H), 1.94-1.77 (m, 3H), 1.01 (d, J=6.0 Hz, 6H), 0.96-0.90 (m, 9H). LCMS: RT=2.312 min, m/z 1176.8 [M+H]⁺.

### Example B-30. Synthesis of (2S,4R)-1-((S)-2-(4-(2-(4-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-4-oxobutoxy)ethoxy)butanamido)-3,3-dimethylbutanoyl)-4-hydroxy-N-(4-(4-methylthiazol-5-yl)benzyl)pyrrolidine-2-carboxamide

The title compound was prepared using general procedures described for (2S,4R)-1-((S)-2-(10-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-10-oxodecanamido)-3,3-dimethylbutanoyl)-4-hydroxy-N—((S)-1-(4-(4-methylthiazol-5-yl)phenyl)ethyl)pyrrolidine-2-carboxamide.

### Example B-31. Synthesis of (2S,4R)-1-[(2S)-2-[[10-[4-[5-[2-fluoro-5-[[4-fluoro-2-(trifluoromethyl)benzoyl]amino]-4-[(3R,5S)-3,4,5-trimethylpiperazin-1-yl]phenyl]pyrimidin-2-yl]piperazin-1-yl]-10-oxo-decanoyl]amino]-3,3-dimethylbutanoyl]-4-hydroxy-N-[(1S)-1-[2-methoxy-4-(4-methylthiazol-5-yl)phenyl]ethyl]pyrrolidine-2-carboxamide

The title compound was prepared using general procedures described for (2S,4R)-1-((S)-2-(10-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-10-oxodecanamido)-3,3-dimethylbutanoyl)-4-hydroxy-N—((S)-1-(4-(4-methylthiazol-5-yl)phenyl)ethyl)pyrrolidine-2-carboxamide. HNMR: DMSO-d₆, 400 MHz. δ 9.69 (s, 1H), 8.98 (s, 1H), 8.53 (s, 2H), 8.34-8.27 (m, 1H), 7.84-7.68 (m, 5H), 7.33-7.25 (m, 1H), 7.12-7.00 (m, 3H), 5.22-5.04 (m, 2H), 4.56-4.40 (m, 2H), 4.31-4.23 (m, 1H), 3.85 (s, 3H), 3.83-3.74 (m, 4H), 3.61-3.53 (m, 6H), 3.07-2.98 (m, 2H), 2.47 (s, 3H), 2.37-1.74 (m, 14H), 1.54-1.43 (m, 4H), 1.30-1.23 (m, 10H), 1.03-0.99 (m, 6H), 0.93 (s, 9H). LCMS: RT=2.431 min, m/z 1231.9 [M+H]⁺.

### Example B-32. Synthesis of (2S,4R)-1-[(2S)-2-[3-[2-[3-[4-[5-[2-fluoro-5-[[4-fluoro-2-(trifluoromethyl)benzoyl]amino]-4-[(3R,5S)-3,4,5-trimethylpiperazin-1-yl]phenyl]pyrimidin-2-yl]piperazin-1-yl]-3-oxo-propoxy]ethoxy]propanoylamino]-3,3-dimethyl-butanoyl]-4-hydroxy-N-[(1S)-1-[2-methoxy-4-(4-methylthiazol-5-yl)phenyl]ethyl]pyrrolidine-2-carboxamide

The title compound was prepared using general procedures described for (2S,4R)-1-((S)-2-(10-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-10-oxodecanamido)-3,3-dimethylbutanoyl)-4-hydroxy-N—((S)-1-(4-(4-methylthiazol-5-yl)phenyl)ethyl)pyrrolidine-2-carboxamide. HNMR: DMSO-d₆, 400 MHz. δ 9.86-9.66 (m, 1H), 8.98 (s, 1H), 8.54 (s, 2H), 8.35-8.10 (m, 1H), 7.90-7.65 (m, 5H), 7.35-7.24 (m, 1H), 7.06-6.97 (m, 2H), 6.52 (s, 1H), 5.22-5.06 (m, 2H), 4.59-4.39 (m, 2H), 4.32-4.23 (m, 1H), 3.89-3.72 (m, 8H), 3.67-3.56 (m, 10H), 3.51-3.47 (m, 4H), 3.27-3.17 (m, 6H), 2.68-2.61 (m, 4H), 2.47 (s, 3H), 2.39-2.31 (m, 4H), 2.08-1.71 (m, 3H), 1.34-1.21 (m, 6H), 0.93 (s, 9H). LCMS: RT=2.361 min, m/z 1234.9 [M+H]⁺.

### Example B-33. Synthesis of (2S,4R)-1-((S)-2-(2-(4-(4-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazine-1-carbonyl)piperidin-1-yl)phenyl)acetamido)-3,3-dimethylbutanoyl)-4-hydroxy-N—((S)-1-(4-(4-methylthiazol-5-yl)phenyl)ethyl)pyrrolidine-2-carboxamide

### A. Step 1

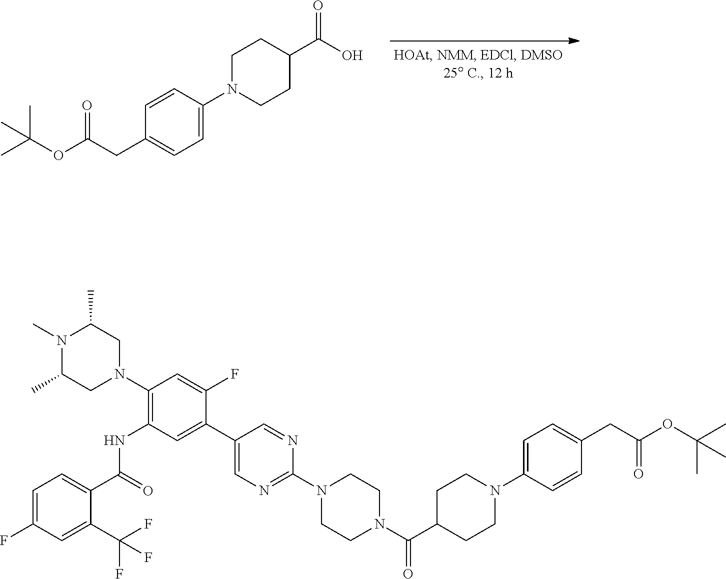 [SMILES: CC(C)(C)OC(=O)Cc1ccc(N2CCC(C(=O)O)CC2)cc1 ; C[C@@H]1CN(c2cc(F)c(-c3cnc(N4CCN(C(=O)C5CCN(c6ccc(CC(=O)OC(C)(C)C)cc6)CC5)CC4)nc3)cc2NC(=O)c2ccc(F)cc2C(F)(F)F)C[C@H](C)N1C]

To a solution of 1-(4-(2-(tert-butoxy)-2-oxoethyl)phenyl)piperidine-4-carboxylic acid (125 mg, 391.37 μmol), 4-fluoro-N-(4-fluoro-5-(2-(piperazin-1-yl)pyrimidin-5-yl)-2-((3R,5S)-3,4,5-trimethylpiperazin-1-yl)phenyl)-2-(trifluoromethyl)benzamide (122.51 mg, 195.68 μmol, HCl) and NMM (118.76 mg, 1.17 mmol, 129.08 μL) in DMSO (5 mL) were added EDCI (150.05 mg, 782.73 μmol) and HOAt (106.54 mg, 782.73 μmol). The resulting mixture was stirred at 25° C. for 12 hours. The reaction mixture was diluted with H₂O (20 mL) and extracted with ethyl acetate (20 mL×3). The combined organic layer was washed with brine (30 mL×3), dried over anhydrous Na₂SO₄, filtered, and concentrated in vacuo to give tert-butyl 2-(4-(4-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazine-1-carbonyl)piperidin-1-yl)phenyl)acetate (243 mg, crude) as brown oil. LCMS: RT=0.519 min, m/z 891.7 [M+H]⁺.

### B. Step 2

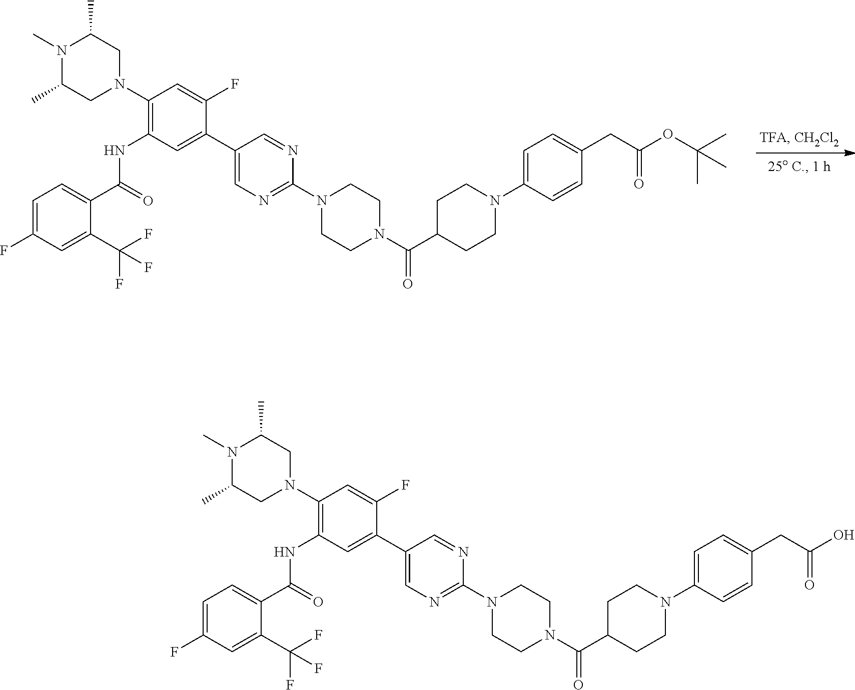 [SMILES: C[C@@H]1CN(c2cc(F)c(-c3cnc(N4CCN(C(=O)C5CCN(c6ccc(CC(=O)OC(C)(C)C)cc6)CC5)CC4)nc3)cc2NC(=O)c2ccc(F)cc2C(F)(F)F)C[C@H](C)N1C ; C[C@@H]1CN(c2cc(F)c(-c3cnc(N4CCN(C(=O)C5CCN(c6ccc(CC(=O)O)cc6)CC5)CC4)nc3)cc2NC(=O)c2ccc(F)cc2C(F)(F)F)C[C@H](C)N1C]

To a solution of tert-butyl 2-(4-(4-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazine-1-carbonyl)piperidin-1-yl)phenyl)acetate (243 mg, 272.73 μmol) in CH₂Cl₂ (2 mL) was added TFA (2.30 g, 20.19 mmol, 1.5 mL). The resulting mixture was stirred at 25° C. for 1 hour. The mixture was concentrated in vacuo. The residue was purified by prep-HPLC (column: Waters Xbridge C18 150*50 mm*10 um; mobile phase: [water(NH₄HCO₃)-ACN]; gradient: 25%-55% B over 10 min) to give 2-(4-(4-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazine-1-carbonyl)piperidin-1-yl)phenyl)acetic acid (128 mg, 153.32 μmol, 56.21% yield) as a pink solid. ¹H NMR: DMSO-d₆, 400 MHz. δ 9.70 (s, 1H), 8.61-8.46 (m, 2H), 7.89-7.64 (m, 4H), 7.13-7.03 (m, 3H), 6.94-6.81 (m, 2H), 3.91-3.52 (m, 11H), 3.46-3.39 (m, 3H), 3.08-2.96 (m, 2H), 2.89-2.67 (m, 3H), 2.37-2.25 (m, 2H), 2.18 (s, 3H), 1.80-1.61 (m, 4H), 1.06-0.96 (m, 6H). LCMS: RT=0.456 min, m/z 835.5 [M+H]⁺.

### C. Step 3

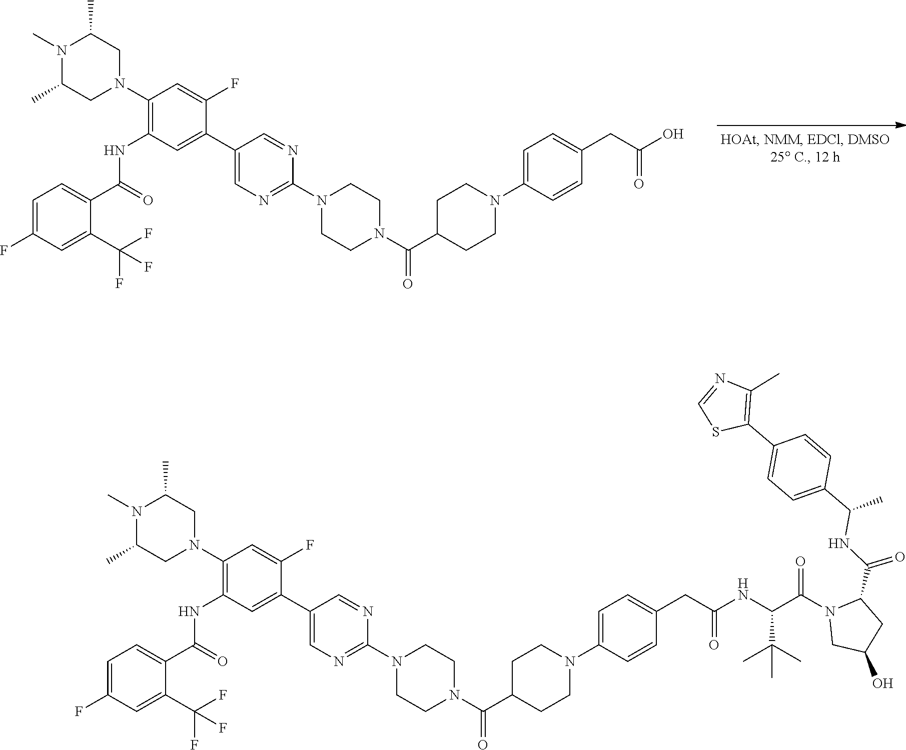 [SMILES: C[C@@H]1CN(c2cc(F)c(-c3cnc(N4CCN(C(=O)C5CCN(c6ccc(CC(=O)O)cc6)CC5)CC4)nc3)cc2NC(=O)c2ccc(F)cc2C(F)(F)F)C[C@H](C)N1C ; Cc1ncsc1-c1ccc([C@H](C)NC(=O)[C@@H]2C[C@@H](O)CN2C(=O)[C@@H](NC(=O)Cc2ccc(N3CCC(C(=O)N4CCN(c5ncc(-c6cc(NC(=O)c7ccc(F)cc7C(F)(F)F)c(N7C[C@@H](C)N(C)[C@@H](C)C7)cc6F)cn5)CC4)CC3)cc2)C(C)(C)C)cc1]

To a solution of 2-(4-(4-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazine-1-carbonyl)piperidin-1l-yl)phenyl)acetic acid (118 mg, 141.34 μmol), (2S,4R)-1-((S)-2-amino-3,3-dimethylbutanoyl)-4-hydroxy-N—((S)-1-(4-(4-methylthiazol-5-yl)phenyl)ethyl)pyrrolidine-2-carboxamide (62.84 mg, 141.34 μmol) and NMM (42.89 mg, 424.02 μmol, 46.62 μL) in DMSO (5 mL) were added EDCI (54.19 mg, 282.68 μmol) and HOAt (38.48 mg, 282.68 μmol). The resulting mixture was stirred at 25° C. for 12 hours. The mixture was concentrated in vacuo. The residue was purified by prep-HPLC (column: Phenomenex luna C18 150*25 mm*10 um; mobile phase: [water(FA)-ACN]; gradient: 18%-48% B over 10 min) to give (2S,4R)-1-((S)-2-(2-(4-(4-(4-(5-(2-fluoro-5-(4-fluoro-2-(trifluoromethyl)benzamido)-4-((3R,5S)-3,4,5-trimethylpiperazin-1l-yl)phenyl)pyrimidin-2-yl)piperazine-1-carbonyl)piperidin-1-yl)phenyl)acetamido)-3,3-dimethylbutanoyl)-4-hydroxy-N—((S)-1-(4-(4-methylthiazol-5-yl)phenyl)ethyl)pyrrolidine-2-carboxamide (71.55 mg, 54.09 μmol, 38.27% yield, 95.37% purity) as a pink solid. ¹H NMR: -d₄, 400 MHz. δ 8.87 (s, 1H), 8.57 (s, 2H), 8.06-7.99 (m, 1H), 7.80-7.74 (m, 1H), 7.66-7.61 (m, 1H), 7.59-7.52 (m, 1H), 7.46-7.39 (m, 4H), 7.25-7.16 (m, 2H), 7.15-7.07 (m, 1H), 7.02-6.92 (m, 2H), 4.75-4.50 (m, 3H), 4.45-4.32 (m, 1H), 3.99-3.82 (m, 5H), 3.78-3.67 (m, 7H), 3.56-3.45 (m, 2H), 3.16-3.03 (m, 2H), 2.92-2.63 (m, 7H), 2.50-2.44 (m, 6H), 2.24-2.11 (m, 1H), 2.01-1.80 (m, 5H), 1.53-1.47 (m, 3H), 1.25-1.17 (m, 6H), 1.02-0.94 (m, 9H). LCMS: RT=1.466 min, m/z 1261.6 [M+H]⁺.

### Example B-34. Synthesis of (2S,4R)-1-((2S)-2-(2-(4-(3-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazine-1-carbonyl)piperidin-1-yl)phenyl)acetamido)-3,3-dimethylbutanoyl)-4-hydroxy-N—((S)-1-(4-(4-methylthiazol-5-yl)phenyl)ethyl)pyrrolidine-2-carboxamide

The title compound was prepared using general procedures described for (2S,4R)-1-((S)-2-(2-(4-(4-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazine-1-carbonyl)piperidin-1-yl)phenyl)acetamido)-3,3-dimethylbutanoyl)-4-hydroxy-N—((S)-1-(4-(4-methylthiazol-5-yl)phenyl)ethyl)pyrrolidine-2-carboxamide. ¹H NMR: MeOD-d₄, 400 MHz δ 8.86 (s, 1H), 8.60-8.53 (m, 2H), 8.03 (d, J=8.0 Hz, 1H), 7.81-7.71 (m, 1H), 7.67-7.60 (m, 1H), 7.60-7.56 (m, 1H), 7.47-7.32 (m, 4H), 7.23-7.18 (m, 2H), 7.12 (d, J=11.6 Hz, 1H), 7.02-6.94 (m, 2H), 5.03-4.97 (m, 1H), 4.61-4.53 (m, 4H), 4.45-4.39 (m, 1H), 3.99-3.82 (m, 5H), 3.75-3.68 (m, 6H), 3.54-3.47 (m, 2H), 3.15-3.08 (m, 2H), 3.06-3.00 (m, 1H), 2.92-2.84 (m, 1H), 2.79-2.65 (m, 4H), 2.51-2.44 (m, 6H), 2.22-2.13 (m, 1H), 2.00-1.89 (m, 2H), 1.86-1.76 (m, 2H), 1.69-1.61 (m, 1H), 1.50 (d, J=5.2 Hz, 3H), 1.25-1.15 (m, 6H), 1.01-0.93 (m, 9H). LCMS: RT=1.526 min, m/z 1261.6 [M+H]⁺.

### Example B-35. Synthesis of (2S,4R)-1-((2S)-2-(2-(3-(3-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazine-1-carbonyl)piperidin-1-yl)phenyl)acetamido)-3,3-dimethylbutanoyl)-4-hydroxy-N—((S)-1-(4-(4-methylthiazol-5-yl)phenyl)ethyl)pyrrolidine-2-carboxamide

The title compound was prepared using general procedures described for (2S,4R)-1-((S)-2-(2-(4-(4-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazine-1-carbonyl)piperidin-1-yl)phenyl)acetamido)-3,3-dimethylbutanoyl)-4-hydroxy-N—((S)-1-(4-(4-methylthiazol-5-yl)phenyl)ethyl)pyrrolidine-2-carboxamide. ¹H NMR: CDCl₃, 400 MHz. δ 8.70-8.66 (m, 1H), 8.60-8.54 (m, 4H), 7.70-7.64 (m, 1H), 7.60-7.47 (m, 2H), 7.42-7.34 (m, 5H), 7.26-7.22 (m, 1H), 7.08-7.03 (m, 1H), 6.92-6.87 (m, 1H), 6.84-6.78 (m, 1H), 6.74-6.70 (m, 1H), 6.18 (t, J=9.2 Hz, 1H), 5.11-5.05 (m, 1H), 4.79-4.67 (m, 1H), 4.55-4.48 (m, 2H), 4.13-4.07 (m, 1H), 4.04-3.82 (m, 4H), 3.78-3.64 (m, 6H), 3.63-3.59 (m, 1H), 3.59-3.51 (m, 2H), 3.09-2.99 (m, 1H), 2.96-2.73 (m, 6H), 2.54-2.51 (m, 3H), 2.50-2.45 (m, 2H), 2.20-2.02 (m, 5H), 2.01-1.95 (m, 2H), 1.86-1.72 (m, 3H), 1.46 (d, J=7.2 Hz, 3H), 1.25-1.12 (m, 6H), 0.93 (s, 9H). LCMS: RT=0.859 min, m/z 1261.8 [M+H]⁺.

### Example B-36. Synthesis of (2S,4R)-1-((S)-2-(2-(3-(4-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazine-1-carbonyl)piperidin-1-yl)phenyl)acetamido)-3,3-dimethylbutanoyl)-4-hydroxy-N—((S)-1-(4-(4-methylthiazol-5-yl)phenyl)ethyl)pyrrolidine-2-carboxamide

The title compound was prepared using general procedures described for (2S,4R)-1-((S)-2-(2-(4-(4-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazine-1-carbonyl)piperidin-1-yl)phenyl)acetamido)-3,3-dimethylbutanoyl)-4-hydroxy-N—((S)-1-(4-(4-methylthiazol-5-yl)phenyl)ethyl)pyrrolidine-2-carboxamide. ¹H NMR: CD₃OD-d₄, 400 MHz. δ 8.86 (s, 1H), 8.59 (s, 2H), 8.01 (d, J=8.0 Hz, 1H), 7.79-7.73 (m, 1H), 7.67-7.62 (m, 1H), 7.60-7.52 (m, 1H), 7.46-7.39 (m, 4H), 7.23-7.16 (m, 1H), 7.10 (d, J=12.0 Hz, 1H), 7.01-6.88 (m, 2H), 6.80-6.74 (m, 1H), 5.03-4.98 (m, 1H), 4.62-4.60 (m, 3H), 4.45-4.39 (m, 1H), 4.00-3.92 (m, 2H), 3.91-3.84 (m, 3H), 3.81-3.67 (m, 7H), 3.59-3.53 (m, 2H), 3.10-2.99 (m, 2H), 2.97-2.76 (m, 3H), 2.65-2.57 (m, 2H), 2.48-2.47 (m, 3H), 2.45-2.42 (m, 1H), 2.35-2.30 (m, 3H), 2.25-2.13 (m, 1H), 2.02-1.78 (m, 5H), 1.51 (d, J=7.2 Hz, 3H), 1.17-1.13 (m, 6H), 1.04-0.95 (m, 9H). LCMS: RT=1.487 min, m/z 1261.8 [M+H]⁺.

### Example B-37. Synthesis of 1-(4-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)phenyl)-N—((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)piperidine-4-carboxamide

### A. Step 1

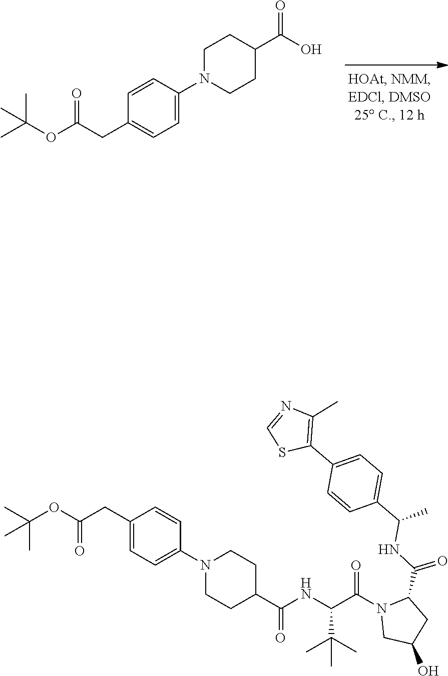 [SMILES: CC(C)(C)OC(=O)Cc1ccc(N2CCC(C(=O)O)CC2)cc1 ; Cc1ncsc1-c1ccc([C@H](C)NC(=O)[C@@H]2C[C@@H](O)CN2C(=O)[C@@H](NC(=O)C2CCN(c3ccc(CC(=O)OC(C)(C)C)cc3)CC2)C(C)(C)C)cc1]

To a solution of 1-(4-(2-(tert-butoxy)-2-oxoethyl)phenyl)piperidine-4-carboxylic acid (125 mg, 391.37 μmol), (2S,4R)-1-((S)-2-amino-3,3-dimethylbutanoyl)-4-hydroxy-N—((S)-1-(4-(4-methylthiazol-5-yl)phenyl)ethyl)pyrrolidine-2-carboxamide (174.00 mg, 391.37 μmol) and NMM (118.76 mg, 1.17 mmol, 129.08 μL) in DMSO (5 mL) were added EDCI (150.05 mg, 782.73 μmol) and HOAt (106.54 mg, 782.73 μmol). The resulting mixture was stirred at 25° C. for 12 hours. The mixture was diluted with H₂O (20 mL) and extracted with ethyl acetate (20 mL×3). The combined organic layers were washed with brine (30 mL×3), dried over anhydrous Na₂SO₄, filtered, and concentrated in vacuo to give tert-butyl 2-(4-(4-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)carbamoyl)piperidin-1-yl)phenyl)acetate (260 mg, crude) as a light yellow solid. LCMS: RT=0.517 min, m/z 746.6 [M+H]⁺.

### B. Step 2

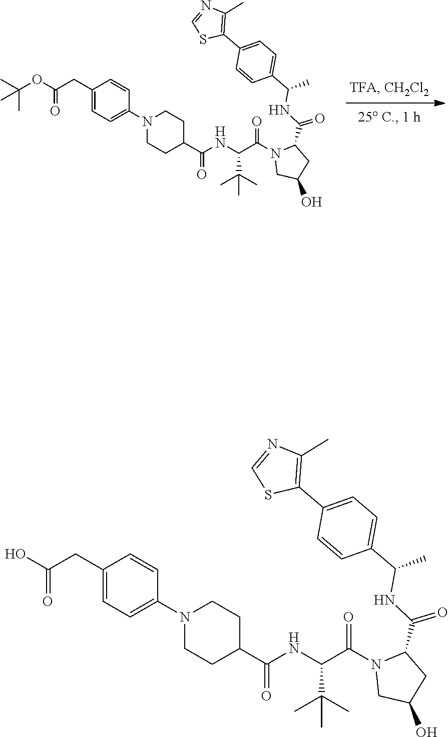 [SMILES: Cc1ncsc1-c1ccc([C@H](C)NC(=O)[C@@H]2C[C@@H](O)CN2C(=O)[C@@H](NC(=O)C2CCN(c3ccc(CC(=O)OC(C)(C)C)cc3)CC2)C(C)(C)C)cc1 ; Cc1ncsc1-c1ccc([C@H](C)NC(=O)[C@@H]2C[C@@H](O)CN2C(=O)[C@@H](NC(=O)C2CCN(c3ccc(CC(=O)O)cc3)CC2)C(C)(C)C)cc1]

To a solution of tert-butyl 2-(4-(4-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)carbamoyl)piperidin-1-yl)phenyl)acetate (260 mg, 348.54 μmol) in CH₂C₂ (2 mL) was added TFA (2.30 g, 20.19 mmol, 1.5 mL). The resulting mixture was stirred at 25° C. for 1 hour. The mixture was concentrated in vacuo. The residue was purified by prep-HPLC (column: Waters Xbridge C18 150*50 mm*10 um; mobile phase: [water(NH₄HCO₃)-ACN]; gradient: 12%-42% B over 10 min) to give 2-(4-(4-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)carbamoyl)piperidin-1-yl)phenyl)acetic acid (187 mg, 271.07 μmol, 77.77% yield) as a pink solid. ¹H NMR: DMSO-d₆, 400 MHz. δ 8.98 (s, 1H), 8.44-8.34 (m, 1H), 7.88-7.76 (m, 1H), 7.45-7.41 (m, 2H), 7.41-7.35 (m, 2H), 7.13-7.03 (m, 2H), 6.90-6.82 (m, 2H), 4.99-4.83 (m, 1H), 4.57-4.48 (m, 1H), 4.47-4.38 (m, 1H), 4.33-4.23 (m, 1H), 3.69-3.57 (m, 4H), 3.39 (s, 3H), 2.68-2.56 (m, 2H), 2.45 (s, 3H), 2.12-1.96 (m, 1H), 1.85-1.73 (m, 2H), 1.70-1.54 (m, 3H), 1.48-1.33 (m, 3H), 0.93 (s, 9H). LCMS: RT=0.461 min, m/z 690.5 [M+H]⁺.

### C. Step 3

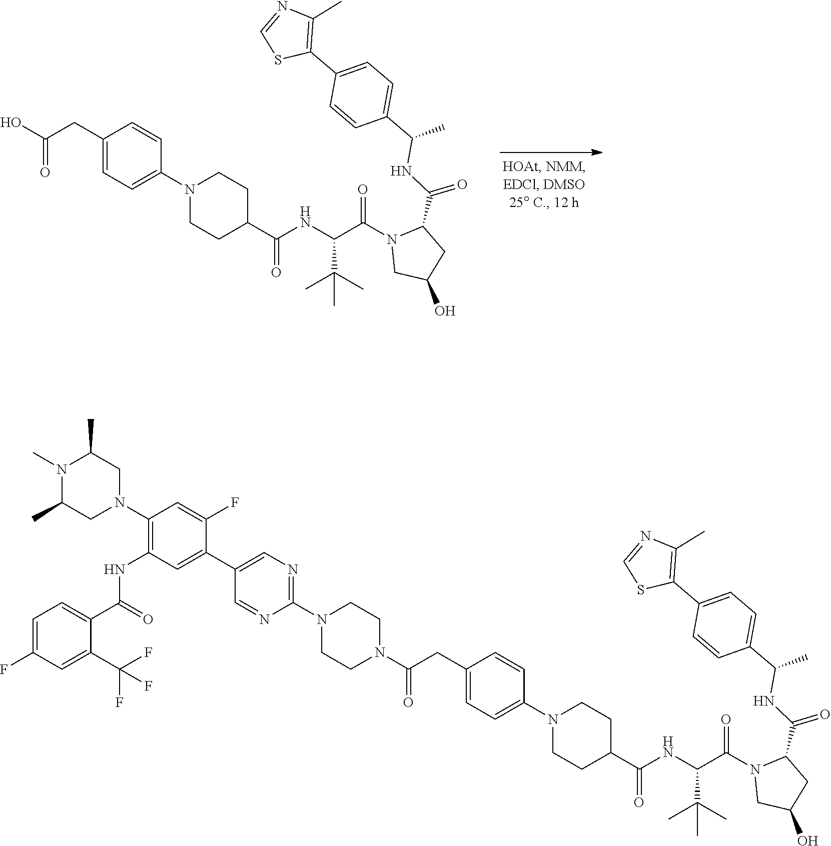 [SMILES: Cc1ncsc1-c1ccc([C@H](C)NC(=O)[C@@H]2C[C@@H](O)CN2C(=O)[C@@H](NC(=O)C2CCN(c3ccc(CC(=O)O)cc3)CC2)C(C)(C)C)cc1 ; Cc1ncsc1-c1ccc([C@H](C)NC(=O)[C@@H]2C[C@@H](O)CN2C(=O)[C@@H](NC(=O)C2CCN(c3ccc(CC(=O)N4CCN(c5ncc(-c6cc(NC(=O)c7ccc(F)cc7C(F)(F)F)c(N7C[C@@H](C)N(C)[C@@H](C)C7)cc6F)cn5)CC4)cc3)CC2)C(C)(C)C)cc1]

yl)phenyl)ethyl)carbamoyl)pyrrolidin-1-yl)-3,3-dimethyl-1-oxobutan-2-yl)carbamoyl)piperidin-1-yl)phenyl)acetic acid (177 mg, 256.57 μmol), 4-fluoro-N-(4-fluoro-5-(2-(piperazin-1-yl)pyrimidin-5-yl)-2-((3R,5S)-3,4,5-trimethylpiperazin-1-yl)phenyl)-2-(trifluoromethyl)benzamide (128.50 mg, 205.26 μmol, HCl) and NMM (77.85 mg, 769.72 μmol, 84.62 μL) in DMSO (5 mL) were added EDCI (98.37 mg, 513.15 μmol) and HOAt (69.84 mg, 513.15 μmol). The resulting mixture was stirred at 25° C. for 12 hours. The mixture was concentrated in vacuo. The residue was purified by prep-HPLC (column: Phenomenex luna C18 150*25 mm*10 um; mobile phase: [water(FA)-ACN]; gradient: 18%-48% B over 10 min) to give 1-(4-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)phenyl)-N—((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)piperidine-4-carboxamide (121.40 mg, 92.36 μmol, 36.00% yield, 95.97% purity) as a pink solid. ¹H NMR: CD₃OD-d₄, 400 MHz. δ 8.87 (s, 1H), 8.57-8.51 (m, 2H), 8.04-7.97 (m, 1H), 7.78-7.75 (m, 1H), 7.68-7.61 (m, 1H), 7.59-7.52 (m, 1H), 7.47-7.39 (m, 4H), 7.20-7.15 (m, 2H), 7.14-7.07 (m, 1H), 7.01-6.93 (m, 2H), 5.05-4.97 (m, 1H), 4.66-4.54 (m, 3H), 4.45-4.39 (m, 1H), 3.88-3.83 (m, 2H), 3.77-3.61 (m, 11H), 3.17-3.06 (m, 2H), 2.80-2.64 (m, 6H), 2.54-2.44 (m, 7H), 2.27-2.13 (m, 1H), 2.00-1.78 (m, 5H), 1.50 (d, J=7.2 Hz, 3H), 1.25-1.18 (m, 6H), 1.06-1.00 (m, 9H). LCMS: RT=1.465 min, m/z 1261.6 [M+H]⁻.

### Example B-38. Synthesis of 1-(3-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)phenyl)-N—((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)piperidine-4-carboxamide

The title compound was prepared using general procedures described for 1-(4-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)phenyl)-N—((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)piperidine-4-carboxamide. ¹H NMR: MeOD-d₆, 400 MHz. δ 8.87 (s, 1H), 8.56-8.53 (m, 2H), 8.05-7.96 (m, 1H), 7.84-7.72 (m, 2H), 7.68-7.61 (m, 1H), 7.59-7.51 (m, 1H), 7.45-7.40 (m, 4H), 7.24-7.18 (m, 1H), 7.15-7.10 (m, 1H), 6.95-6.86 (m, 2H), 6.77 (d, J=7.6 Hz, 1H), 5.05-4.98 (m, 1H), 4.61-4.57 (m, 3H), 4.45-4.39 (m, 1H), 3.89-3.82 (m, 3H), 3.82-3.79 (m, 2H), 3.77-3.68 (m, 7H), 3.67-3.62 (m, 2H), 3.18-3.10 (m, 2H), 2.84-2.68 (m, 6H), 2.53-2.50 (m, 3H), 2.48 (s, 3H), 2.24-2.13 (m, 1H), 1.99-1.81 (m, 5H), 1.53-1.48 (m, 3H), 1.26-1.21 (m, 6H), 1.04 (s, 9H). LCMS: RT=1.494 min, m/z 1261.7 [M+H]⁺.

### Example B-39. Synthesis of 1-[4-[2-[4-[5-[2-fluoro-5-[[4-fluoro-2-(trifluoromethyl)benzoyl]amino]-4-[(3R,5S)-3,4,5-trimethylpiperazin-1-yl]phenyl]pyrimidin-2-yl]piperazin-1-yl]-2-oxo-ethyl]phenyl]-N-[(1S)-1-[(2S,4R)-4-hydroxy-2-[[(1S)-1-[4-(4-methylthiazol-5-yl)phenyl]ethyl]carbamoyl]pyrrolidine-1-carbonyl]-2,2-dimethyl-propyl]piperidine-3-carboxamide

The title compound was prepared using general procedures described for 1-(4-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)phenyl)-N—((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)piperidine-4-carboxamide. ¹HNMR: CD₃OD-d₄, 400 MHz. δ 8.87 (s, 1H), 8.58-8.47 (m, 2H), 8.01 (d, J=8.0 Hz, 1H), 7.81-7.72 (m, 1H), 7.64 (d, J=9.2 Hz, 1H), 7.58-7.48 (m, 1H), 7.47-7.37 (m, 4H), 7.26-7.17 (m, 2H), 7.13-7.01 (m, 3H), 4.99 (d, J=7.2 Hz, 1H), 4.63-4.53 (m, 4H), 4.42 (br s, 1H), 3.91-3.58 (m, 12H), 3.08 (br d, J=10.8 Hz, 4H), 2.74-2.55 (m, 5H), 2.47 (d, J=1.2 Hz, 3H), 2.42 (s, 3H), 2.22-2.13 (m, 1H), 2.01-1.65 (m, 5H), 1.57-1.46 (m, 3H), 1.18 (br d, J=5.6 Hz, 6H), 1.06-0.94 (m, 9H). LCMS: RT=1.561 min, m/z 1261.6 [M+H]⁺.

### Example B-40. Synthesis of 1-(3-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)phenyl)-N—((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)piperidine-3-carboxamide

The title compound was prepared using general procedures described for 1-(4-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)phenyl)-N—((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)piperidine-4-carboxamide. ¹H NMR: CDCl₃, 400 MHz. δ 8.68 (s, 1H), 8.60-8.50 (m, 4H), 7.93-7.71 (m, 1H), 7.69-7.46 (m, 3H), 7.43-7.35 (m, 5H), 7.26-7.22 (m, 1H), 7.07-6.81 (m, 4H), 5.13-5.03 (m, 1H), 4.82 (t, J=8.0 Hz, 1H), 4.53-4.40 (m, 2H), 4.27-4.19 (m, 1H), 3.91-3.67 (m, 8H), 3.63-3.51 (m, 3H), 3.50-3.20 (m, 3H), 3.16-2.96 (m, 2H), 2.89-2.74 (m, 4H), 2.65-2.51 (m, 7H), 2.41-2.37 (m, 3H), 2.19-1.68 (m, 6H), 1.49-1.44 (m, 3H), 1.25-1.13 (m, 6H), 1.05-0.97 (m, 9H). LCMS: RT=0.859 min, m/z 1261.7 [M+H]⁺.

### Example B-41. Synthesis of 3-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)-N—((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)-3-azaspiro[5.5]undecane-9-carboxamide

The title compound was prepared using general procedures described for 1-(4-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)phenyl)-N—((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)piperidine-4-carboxamide. ¹H NMR: CD₃OD-d₄, 400 MHz. δ 8.87 (s, 1H), 8.60-8.55 (m, 2H), 8.01 (d, J=8.4 Hz, 1H), 7.81-7.73 (m, 1H), 7.68-7.62 (m, 1H), 7.60-7.52 (m, 1H), 7.48-7.38 (m, 4H), 7.10 (d, J=12.0 Hz, 1H), 5.02-4.97 (m, 1H), 4.95-4.91 (m, 2H), 4.64-4.52 (m, 6H), 4.46-4.41 (m, 1H), 4.00-3.82 (m, 5H), 3.79-3.65 (m, 5H), 3.08-3.02 (m, 2H), 2.65-2.56 (m, 2H), 2.54-2.51 (m, 2H), 2.48 (s, 3H), 2.46-2.42 (m, 1H), 2.32 (s, 3H), 2.24-2.14 (m, 1H), 2.12-1.87 (m, 1H), 1.85-1.73 (m, 2H), 1.69-1.55 (m, 6H), 1.53-1.49 (m, 3H), 1.47-1.40 (m, 2H), 1.37-1.19 (m, 2H), 1.16-1.13 (m, 6H), 1.06-1.00 (m, 9H). LCMS: RT=1.445 min, m/z 1253.8[M+H]⁺.

### Example B-42. Synthesis of (2S,4R)-1-((S)-2-(2-(9-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazine-1-carbonyl)-3-azaspiro[5.5]undecan-3-yl)acetamido)-3,3-dimethylbutanoyl)-4-hydroxy-N—((S)-1-(4-(4-methylthiazol-5-yl)phenyl)ethyl)pyrrolidine-2-carboxamide

The title compound was prepared using general procedures described for (2S,4R)-1-((S)-2-(2-(4-(4-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazine-1-carbonyl)piperidin-1-yl)phenyl)acetamido)-3,3-dimethylbutanoyl)-4-hydroxy-N—((S)-1-(4-(4-methylthiazol-5-yl)phenyl)ethyl)pyrrolidine-2-carboxamide. ¹H NMR: MeOD-d₄, 400 MHz. δ 8.87 (s, 1H), 8.57 (s, 2H), 8.02 (d, J=8.4 Hz, 1H), 7.82-7.74 (m, 1H), 7.70-7.62 (m, 1H), 7.60-7.52 (m, 1H), 7.49-7.34 (m, 4H), 7.12 (d, J=12.0 Hz, 1H), 5.06-4.97 (m, 1H), 4.95-4.89 (m, 2H), 4.65-4.62 (m, 1H), 4.61-4.51 (m, 4H), 4.49-4.32 (m, 1H), 3.99-3.67 (m, 9H), 3.17-3.08 (m, 3H), 2.79-2.55 (m, 8H), 2.53-2.40 (m, 6H), 2.29-1.89 (m, 2H), 1.88-1.77 (m, 2H), 1.76-1.56 (m, 6H), 1.54-1.50 (m, 3H), 1.38-1.24 (m, 2H), 1.24-1.16 (m, 6H), 1.11-0.96 (m, 9H). LCMS: RT=1.455 min, m/z 1253.9 [M+H]⁺.

### Example B-43. Synthesis of (2S,4R)-1-[(2S)-2-[[3-[4-[4-[5-[2-fluoro-5-[[4-fluoro-2-(trifluoromethyl)benzoyl]amino]-4-[(3R,5S)-3,4,5-trimethylpiperazin-1-yl]phenyl]pyrimidin-2-yl]piperazine-1-carbonyl]-1-piperidyl]benzoyl]amino]-3,3-dimethyl-butanoyl]-4-hydroxy-N-[(1S)-1-[4-(4-methylthiazol-5-yl)phenyl]ethyl]pyrrolidine-2-carboxamide

The title compound was prepared using general procedures described for (2S,4R)-1-((S)-2-(2-(4-(4-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazine-1-carbonyl)piperidin-1-yl)phenyl)acetamido)-3,3-dimethylbutanoyl)-4-hydroxy-N—((S)-1-(4-(4-methylthiazol-5-yl)phenyl)ethyl)pyrrolidine-2-carboxamide. LCMS: RT=1.627 min, m/z 1247.6 [M+H]⁺. ¹H NMR: DMSO-d₆, 400 MHz. δ 9.78-9.66 (m, 1H), 9.04-8.96 (m, 1H), 8.61-8.53 (m, 2H), 8.42 (d, J=8.0 Hz, 1H), 7.91 (d, J=8.8 Hz, 1H), 7.85-7.71 (m, 4H), 7.47-7.42 (m, 2H), 7.42-7.36 (m, 3H), 7.32-7.23 (m, 2H), 7.17-7.07 (m, 2H), 5.14 (d, J=3.6 Hz, 1H), 5.00-4.89 (m, 1H), 4.50-4.44 (m, 1H), 4.46 (t, 1=8.4 Hz, 1H), 4.34-4.28 (m, 1H), 3.95-3.73 (m, 7H), 3.73-3.64 (m, 4H), 3.63-3.57 (m, 2H), 3.08-3.03 (m, 2H), 2.96-2.76 (m, 4H), 2.46 (s, 3H), 2.35-1.99 (m, 7H), 1.89-1.64 (m, 6H), 1.39 (d, J=6.8 Hz, 3H), 1.10-0.96 (m, 12H).

### Example B-44. Synthesis of (2S,4R)-1-((S)-2-(4-(4-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazine-1-carbonyl)piperidin-1-yl)benzamido)-3,3-dimethylbutanoyl)-4-hydroxy-N—((S)-1-(4-(4-methylthiazol-5-yl)phenyl)ethyl)pyrrolidine-2-carboxamide

The title compound was prepared using general procedures described for (2S,4R)-1-((S)-2-(2-(4-(4-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazine-1-carbonyl)piperidin-1-yl)phenyl)acetamido)-3,3-dimethylbutanoyl)-4-hydroxy-N—((S)-1-(4-(4-methylthiazol-5-yl)phenyl)ethyl)pyrrolidine-2-carboxamide. LCMS: RT=1.763 min, m/z 1247.6 [M+H]⁺. ¹H NMR: DMSO-d₆, 400 MHz. δ 9.72 (s, 1H), 8.98 (s, 1H), 8.55 (s, 2H), 8.42 (d, J=8.0 Hz, 1H), 7.84-7.70 (m, 6H), 7.51 (d, J=8.4 Hz, 1H), 7.45-7.42 (m, 2H), 7.40-7.37 (m, 2H), 7.17-7.05 (m, 1H), 6.98-6.94 (m, 2H), 5.12 (d, J=3.6 Hz, 1H), 4.93 (t, J=7.6 Hz, 1H), 4.74 (d, J=9.2 Hz, 1H), 4.45 (t, J=8.0 Hz, 1H), 4.35-4.26 (m, 1H), 3.98-3.45 (m, 10H), 3.13-2.82 (m, 6H), 2.46 (s, 3H), 2.35-2.13 (m, 5H), 2.06-2.00 (m, 1H), 1.84-1.61 (m, 6H), 1.38 (d, J=6.8 Hz, 3H), 1.05-0.98 (m, 13H).

### Example B-45. Synthesis of (2S,4R)-1-((2S)-2-(4-(3-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazine-1-carbonyl)piperidin-1-yl)benzamido)-3,3-dimethylbutanoyl)-4-hydroxy-N—((S)-1-(4-(4-methylthiazol-5-yl)phenyl)ethyl)pyrrolidine-2-carboxamide

The title compound was prepared using general procedures described for (2S,4R)-1-((S)-2-(2-(4-(4-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazine-1-carbonyl)piperidin-1-yl)phenyl)acetamido)-3,3-dimethylbutanoyl)-4-hydroxy-N—((S)-1-(4-(4-methylthiazol-5-yl)phenyl)ethyl)pyrrolidine-2-carboxamide. LCMS: RT=1.808 min, m/z 1247.6 [M+H]⁺. 1H NMR: DMSO-d₆, 400 MHz. δ 9.69 (s, 1H), 8.98 (s, 1H), 8.54 (s, 2H), 8.41 (d, J=7.6 Hz, 1H), 7.86-7.65 (m, 6H), 7.49 (d, J=9.2 Hz, 1H), 7.45-7.30 (m, 4H), 7.08 (d, J=12.0 Hz, 1H), 6.95 (d, J=9.2 Hz, 2H), 5.12 (d, J=3.3 Hz, 11H), 4.92 (t, J=7.2 Hz, 11H), 4.74 (d, J=9.2 Hz, 11H), 4.44 (t, J=8.0 Hz, 1H), 4.29 (s, 1H), 3.97-3.75 (m, 6H), 3.71-3.54 (m, 6H), 3.08-2.99 (m, 2H), 2.96-2.74 (m, 3H), 2.48-2.41 (m, 5H), 2.36-2.28 (m, 2H), 2.17 (s, 3H), 2.08-1.97 (m, 1H), 1.93-1.84 (m, 1H), 1.83-1.57 (m, 4H), 1.37 (d, J=6.8 Hz, 3H), 1.06-0.95 (m, 15H).

### Example B-46. Synthesis of (2S,4R)-1-((2S)-2-(3-(3-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazine-1-carbonyl)piperidin-1-yl)benzamido)-3,3-dimethylbutanoyl)-4-hydroxy-N—((S)-1-(4-(4-methylthiazol-5-yl)phenyl)ethyl)pyrrolidine-2-carboxamide

The title compound was prepared using general procedures described for (2S,4R)-1-((S)-2-(2-(4-(4-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazine-1-carbonyl)piperidin-1-yl)phenyl)acetamido)-3,3-dimethylbutanoyl)-4-hydroxy-N—((S)-1-(4-(4-methylthiazol-5-yl)phenyl)ethyl)pyrrolidine-2-carboxamide. LCMS: RT=1.692 min, m/z 1247.7 [M+H]⁺. 1H NMR: DMSO-d₆, 400 MHz. δ 11.88-10.93 (m, 1H), 9.98-9.74 (m, 1H), 9.16-8.99 (m, 1H), 8.56 (s, 2H), 8.48-8.38 (m, 1H), 8.25-8.03 (m, 2H), 7.99-7.67 (m, 6H), 7.64-7.53 (m, 1H), 7.49-7.34 (m, 4H), 7.31-7.10 (m, 1H), 5.00-4.90 (m, 1H), 4.86-4.76 (m, 1H), 4.48-4.44 (m, 2H), 3.98-3.82 (m, 4H), 3.79-3.52 (m, 11H), 3.46-3.27 (m, 4H), 3.17-3.05 (m, 2H), 2.77 (d, J=4.4 Hz, 2H), 2.61 (d, J=5.2 Hz, 1H), 2.46 (s, 3H), 2.47-2.44 (m, 1H), 2.07-1.90 (m, 3H), 1.84-1.66 (m, 2H), 1.37 (d, J=6.4 Hz, 7H), 1.24 (d, J=6.8 Hz, 2H), 1.04 (d, J=2.4 Hz, 9H).

### Example B-47. Synthesis of 1-(4-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazine-1-carbonyl)phenyl)-1-((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)piperidine-3-carboxamide

The title compound was prepared using general procedures described for 1-(4-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)phenyl)-N—((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)piperidine-4-carboxamide. LCMS: RT=1.757 min, m/z 624.4 [M/2+H]⁺. ¹H NMR: DMSO-d₆, 400 MHz. δ 11.69-11.54 (m, 1H), 10.84-10.68 (m, 1H), 9.93-9.76 (m, 1H), 9.04 (s, 11H), 8.55 (s, 2H), 8.41 (d, J=7.6 Hz, 1H), 8.14-8.02 (m, 1H), 7.94 (d, J=8.4 Hz, 1H), 7.87-7.78 (m, 2H), 7.77-7.66 (m, 1H), 7.53-7.12 (m, 8H), 4.92 (t, J=7.6 Hz, 1H), 4.55-4.50 (m, 1H), 4.46-4.41 (m, 1H), 4.29 (s, 2H), 3.87 (s, 4H), 3.81-3.51 (m, 8H), 3.47-3.27 (m, 3H), 2.85-2.71 (m, 7H), 2.68-2.65 (m, 1H), 2.46 (s, 3H), 2.09-1.56 (m, 6H), 1.50-1.30 (m, 7H), 1.24 (d, J=6.8 Hz, 2H), 0.95-0.94 (m, 9H).

### Example B-48. Synthesis of 1-(4-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazine-1-carbonyl)phenyl)-N—((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)piperidine-4-carboxamide

The title compound was prepared using general procedures described for 1-(4-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)phenyl)-N—((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)piperidine-4-carboxamide. LCMS: RT=1.665 min, m/z 1248.6 [M+H]⁺. ¹H NMR: DMSO-d₆, 400 MHz. δ 9.70 (s, 1H), 8.98 (s, 1H), 8.54 (s, 2H), 8.38 (d, J=8.0 Hz, 1H), 7.86-7.72 (m, 5H), 7.45-7.42 (m, 2H), 7.40-7.37 (m, 2H), 7.35-7.35 (m, 2H), 7.08 (d, J=12.4 Hz, 1H), 6.97 (d, J=9.2 Hz, 2H), 5.11 (d, J=3.2 Hz, 1H), 4.97-4.89 (m, 1H), 4.51 (d, J=10.0 Hz, 1H), 4.43 (t, J=7.6 Hz, 1H), 4.32-4.25 (m, 1H), 3.89-3.58 (m, 13H), 3.03 (d, J=10.0 Hz, 2H), 2.83-2.72 (m, 2H), 2.65-2.56 (m, 1H), 2.46 (s, 4H), 2.32-2.24 (m, 2H), 2.17 (s, 3H), 2.05-1.98 (m, 1H), 1.82-1.75 (m, 2H), 1.70-1.58 (m, 3H), 1.38 (d, J=7.2 Hz, 3H), 1.01 (d, J=6.4 Hz, 6H), 0.95 (s, 9H).

### Example B-49. Synthesis of 1-[3-[4-[5-[2-fluoro-5-[[4-fluoro-2-(trifluoromethyl)benzoyl]amino]-4-[(3R,5S)-3,4,5-trimethylpiperazin-1-yl]phenyl]pyrimidin-2-yl]piperazine-1-carbonyl]phenyl]-N-[(1S)-1-[(2S,4R)-4-hydroxy-2-[[(1S)-1-[4-(4-methylthiazol-5-yl)phenyl]ethyl]carbamoyl]pyrrolidine-1-carbonyl]-2,2-dimethyl-propyl]piperidine-4-carboxamide

The title compound was prepared using general procedures described for 1-(4-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)phenyl)-N—((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)piperidine-4-carboxamide. LCMS: RT=1.599 min, m/z 1247.6 [M+H]⁺. ¹H NMR: DMSO-d₆, 400 MHz. δ 9.70 (s, 1H), 8.98 (s, 1H), 8.59-8.52 (m, 2H), 8.43-8.34 (m, 1H), 7.88-7.68 (m, 5H), 7.47-7.36 (m, 4H), 7.32-7.24 (m, 1H), 7.13-7.00 (m, 2H), 6.94 (s, 1H), 6.78 (d, J=7.6 Hz, 1H), 5.10 (d, J=3.6 Hz, 1H), 4.92 (t, J=7.2 Hz, 1H), 4.54-4.39 (m, 2H), 4.33-4.23 (m, 1H), 3.94-3.58 (m, 10H), 3.48-3.38 (m, 2H), 3.08-3.00 (m, 2H), 2.78-2.67 (m, 2H), 2.61-2.52 (m, 2H), 2.45 (s, 3H), 2.39-2.12 (m, 5H), 2.05-1.97 (m, 1H), 1.83-1.59 (m, 5H), 1.37 (d, J=7.2 Hz, 3H), 1.05-0.98 (m, 6H), 0.95 (s, 9H).

### Example B-50. Synthesis of 1-(3-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazine-1-carbonyl)phenyl)-N—((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)piperidine-3-carboxamide

The title compound was prepared using general procedures described for 1-(4-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethyl)phenyl)-N—((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)piperidine-4-carboxamide. LCMS: RT=1.706 min, m/z 1247.8 [M+H]⁺. ¹H NMR: DMSO-d₆, 400 MHz. δ 11.92-10.56 (m, 1H), 9.95-9.75 (m, 1H), 9.06 (s, 1H), 8.56 (s, 3H), 8.30-7.64 (m, 6H), 7.57-7.12 (m, 8H), 4.97-4.86 (m, 1H), 4.53 (d, J=9.6 Hz, 1H), 4.43 (t, J=8.0 Hz, 2H), 3.95-3.85 (m, 6H), 3.75-3.23 (m, 13H), 3.09 (t, J=12.0 Hz, 2H), 2.78 (d, J=4.4 Hz, 2H), 2.64-2.57 (m, 1H), 2.46 (s, 3H), 2.08-1.55 (m, 6H), 1.37-1.36 (m, 7H), 1.24-1.23 (m, 2H), 0.94-0.93 (m, 9H).

### Example B-51. Synthesis of (2S,4R)-1-[(2S)-2-[(1-fluorocyclopropanecarbonyl)amino]-3,3-dimethyl-butanoyl]-N-[[2-[7-[4-[5-[2-fluoro-5-[[4-fluoro-2-(trifluoromethyl)benzoyl]amino]-4-[(3R,5S)-3,4,5-trimethylpiperazin-1-yl]phenyl]pyrimidin-2-yl]piperazin-1-yl]-7-oxo-heptoxy]-4-(4-methylthiazol-5-yl)phenyl]methyl]-4-hydroxy-pyrrolidine-2-carboxamide

### A. Step 1

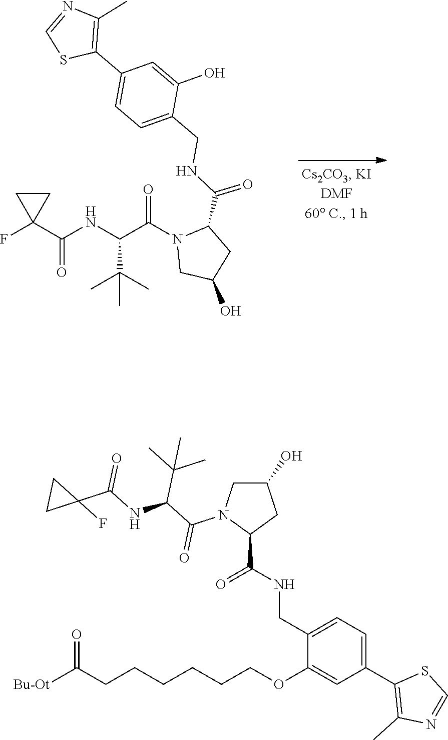

A mixture of (2S,4R)-1-[(2S)-2-[(1-fluorocyclopropanecarbonyl)amino]-3,3-dimethyl-butanoyl]-4-hydroxy-N-[[2-hydroxy-4-(4-methylthiazol-5-yl)phenyl]methyl]pyrrolidine-2-carboxamide (150 mg, 281.62 μmol), tert-butyl 7-bromoheptanoate (89.62 mg, 337.95 μmol), KI (46.75 mg, 281.62 μmol) and Cs₂CO₃ (275.27 mg, 844.87 μmol) in DMF (1.5 mL) was heated to 60° C. and stirred for 1 hour under N₂. LCMS showed the reaction was completed and the desired m/z was detected. The reaction mixture was diluted with water (5 mL) and extracted with Dichloromethane/Methanol (10/1, 8 mL×3). The combined organic phase was washed with brine (8 mL), dried with anhydrous Na₂SO₄, filtered, and concentrated in vacuo. The residue was purified by preparative TLC on silica gel (Petroleum ether/Ethyl acetate=0/1) to afford tert-butyl 7-[2-[[[(2S,4R)-1-[(2S)-2-[(1-fluorocyclopropanecarbonyl)amino]-3,3-dimethyl-butanoyl]-4-hydroxypyrrolidine-2-carbonyl]amino]methyl]-5-(4-methylthiazol-5-yl)phenoxy]heptanoate (105 mg, 140.36 μmol, 49.84% yield, 95.83% purity) as a yellow solid. HNMR: DMSO-d₆, 400 MHz. δ 8.98 (s, 1H), 8.51-8.43 (m, 1H), 7.43-7.36 (m, 1H), 7.32-7.26 (m, 1H), 7.01-6.98 (m, 1H), 6.96-6.93 (m, 1H), 5.21-5.09 (m, 1H), 4.62-4.57 (m, 1H), 4.55-4.48 (m, 1H), 4.38-4.15 (m, 3H), 4.07-4.01 (m, 2H), 3.68-3.45 (m, 2H), 2.45 (s, 3H), 2.22-2.16 (m, 2H), 2.13-2.04 (m, 1H), 1.99-1.88 (m, 1H), 1.78-1.70 (m, 2H), 1.56-1.40 (m, 5H), 1.38 (s, 9H), 1.36-1.29 (m, 3H), 1.24-1.19 (m, 2H), 0.96 (s, 9H). LCMS: RT=0.517, m/z 739.3 [M+Na]⁺.

### B. Step 2

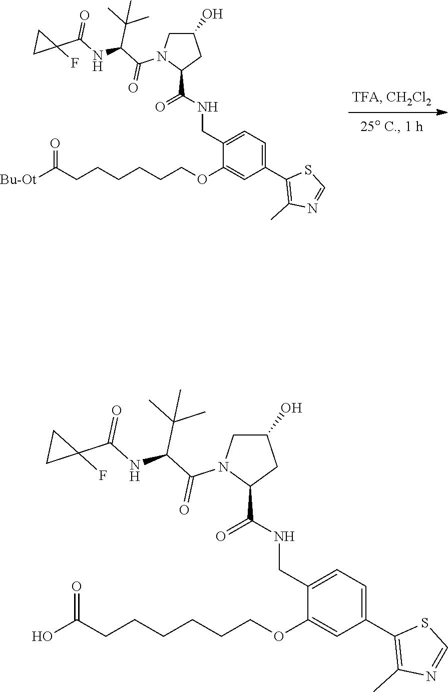

To a solution of tert-butyl 7-[2-[[[(2S,4R)-1-[(2S)-2-[(1-fluorocyclopropanecarbonyl)amino]-3,3-dimethyl-butanoyl]-4-hydroxy-pyrrolidine-2-carbonyl]amino]methyl]-5-(4-methylthiazol-5-yl)phenoxy]heptanoate (100 mg, 139.49 μmol) in CH₂Cl₂ (0.9 mL) was added TFA (460.50 mg, 4.04 mmol, 0.3 mL) at 25° C. The mixture was stirred at 25° C. for 1 hour under N₂. The reaction mixture was concentrated in vacuo to afford the desired product 7-[2-[[[(2S,4R)-1-[(2S)-2-[(1-fluorocyclopropanecarbonyl)amino]-3,3-dimethyl-butanoyl]-4-hydroxypyrrolidine-2-carbonyl]amino]methyl]-5-(4-methylthiazol-5-yl)phenoxy]heptanoic acid (90 mg, crude) as a yellow oil. LCMS: RT=0.439, m/z 661.3 [M+H]⁺.

### C. Step 3

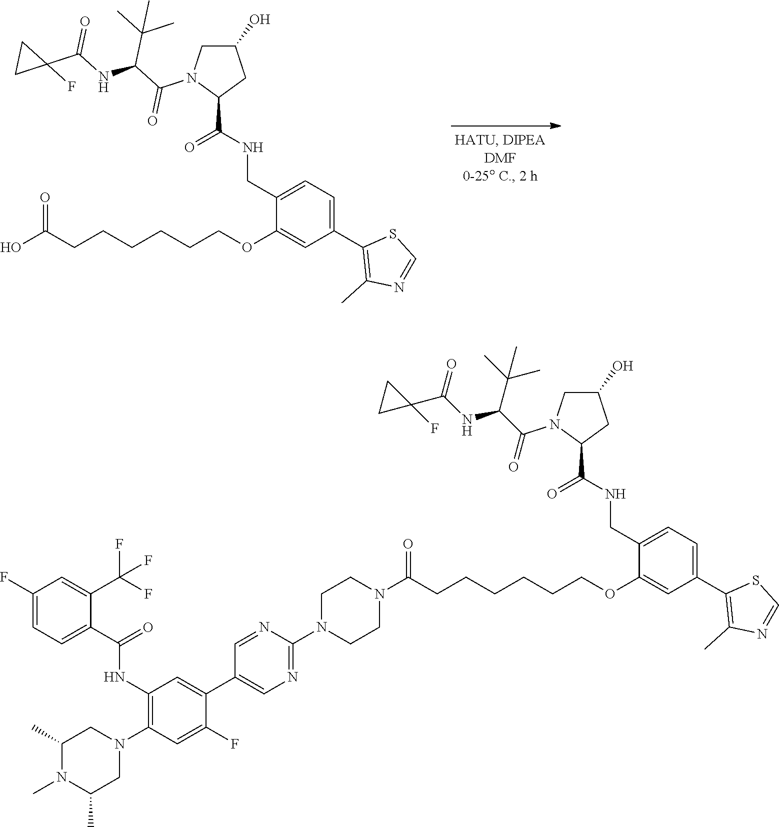 [SMILES: Cc1ncsc1-c1ccc(CNC(=O)[C@@H]2C[C@@H](O)CN2C(=O)[C@@H](NC(=O)C2(F)CC2)C(C)(C)C)c(OCCCCCCC(=O)O)c1 ; Cc1ncsc1-c1ccc(CNC(=O)[C@@H]2C[C@@H](O)CN2C(=O)[C@@H](NC(=O)C2(F)CC2)C(C)(C)C)c(OCCCCCCC(=O)N2CCN(c3ncc(-c4cc(NC(=O)c5ccc(F)cc5C(F)(F)F)c(N5C[C@@H](C)N(C)[C@@H](C)C5)cc4F)cn3)CC2)c1]

To a solution of 7-[2-[[[(2S,4R)-1-[(2S)-2-[(1-fluorocyclopropanecarbonyl)amino]-3,3-dimethyl-butanoyl]-4-hydroxy-pyrrolidine-2-carbonyl]amino]methyl]-5-(4-methylthiazol-5-yl)phenoxy]heptanoic acid (50 mg, 75.67 μmol, crude), 4-fluoro-N-[4-fluoro-5-(2-piperazin-1-ylpyrimidin-5-yl)-2-[(3R,5S)-3,4,5-trimethylpiperazin-1-yl]phenyl]-2-(trifluoromethyl)benzamide (50.13 mg, 75.67 μmol, 2HCl salt) and DIEA (58.68 mg, 454.00 μmol, 79.08 μL) in DMF (0.5 mL) was added HATU (57.54 mg, 151.33 μmol) at 0° C. under N₂. The mixture warmed to 25° C. and stirred for 2 hours. The reaction mixture was diluted with water (3 mL) and extracted with Dichloromethane/Methanol (10/1, 5 mL×3). The combined organic phase was washed with brine (5 mL), dried with anhydrous Na₂SO₄, filtered, and concentrated in vacuo. The residue was purified by preparative HPLC (column: Phenomenex luna C18 150*25 mm*10 um; mobile phase: [water (FA)-ACN]; gradient: 25%-55% B over 8 min) to afford the desired product (2S,4R)-1-[(2S)-2-[(1-fluorocyclopropanecarbonyl)amino]-3,3-dimethyl-butanoyl]-N-[[2-[7-[4-[5-[2-fluoro-5-[[4-fluoro-2-(trifluoromethyl)benzoyl]amino]-4-[(3R,5S)-3,4,5-trimethylpiperazin-1-yl]phenyl]pyrimidin-2-yl]piperazin-1-yl]-7-oxo-heptoxy]-4-(4-methylthiazol-5-yl)phenyl]methyl]-4-hydroxy-pyrrolidine-2-carboxamide (56.96 mg, 44.85 μmol, 59.28% yield, 97.04% purity) as a yellow solid. HNMR: DMSO-d₆, 400 MHz. δ 9.80 (brs, 1H), 8.98 (s, 1H), 8.63-8.40 (m, 3H), 8.06-7.65 (m, 4H), 7.43-6.93 (m, 5H), 5.23-5.09 (m, 1H), 4.69-4.45 (m, 2H), 4.39-3.99 (m, 5H), 3.85-3.73 (m, 4H), 3.68-3.48 (m, 10H), 2.89-2.80 (m, 2H), 2.48-2.43 (m, 6H), 2.40-2.35 (m, 2H), 2.12-2.05 (m, 1H), 1.96-1.88 (m, 1H), 1.81-1.73 (m, 2H), 1.58-1.46 (m, 4H), 1.44-1.16 (m, 12H), 0.95 (s, 9H) LCMS: RT=2.418 min, m/z 1232.8 [M+H]⁺.

### Example B-52. Synthesis of (2S,4R)-1-[(2S)-2-[(1-fluorocyclopropanecarbonyl)amino]-3,3-dimethyl-butanoyl]-n-[[2-[8-[4-[5-[2-fluoro-5-[[4-fluoro-2-(trifluoromethyl)benzoyl]amino]-4-[(3R,5S)-3,4,5-trimethylpiperazin-1-yl]phenyl]pyrimidin-2-yl]piperazin-1-yl]-8-oxo-octoxy]-4-(4-methylthiazol-5-yl)phenyl]methyl]-4-hydroxy-pyrrolidine-2-carboxamide

The title compound was prepared using general procedures described for (2S,4R)-1-[(2S)-2-[(1-fluorocyclopropanecarbonyl)amino]-3,3-dimethyl-butanoyl]-N-[[2-[7-[4-[5-[2-fluoro-5-[[4-fluoro-2-(trifluoromethyl)benzoyl]amino]-4-[(3R,5S)-3,4,5-trimethylpiperazin-1-yl]phenyl]pyrimidin-2-yl]piperazin-1-yl]-7-oxo-heptoxy]-4-(4-methylthiazol-5-yl)phenyl]methyl]-4-hydroxy-pyrrolidine-2-carboxamide. HNMR: DMSO-d₆, 400 MHz. δ 9.69 (s, 1H), 8.97 (s, 1H), 8.61-8.41 (m, 3H), 7.84-7.68 (m, 4H), 7.40 (d, J=7.8 Hz, 1H), 7.34-7.21 (m, 1H), 7.08 (d, J=12.0 Hz, 1H), 7.00 (s, 1H), 6.94 (d, J=8.4 Hz, 1H), 5.16 (d, J=4.0 Hz, 1H), 4.70-4.42 (m, 2H), 4.37-4.25 (m, 2H), 4.24-4.14 (m, 1H), 4.07-4.04 (m, 2H), 3.85-3.73 (m, 4H), 3.68-3.53 (m, 6H), 3.05-3.02 (m, 2H), 2.45 (s, 3H), 2.40-2.26 (m, 6H), 2.17 (s, 3H), 2.12-2.05 (m, 1H), 1.97-1.88 (m, 1H), 1.80-1.72 (m, 2H), 1.56-1.44 (m, 4H), 1.41-1.31 (m, 6H), 1.25-1.18 (m, 2H), 1.01 (d, J=6.4 Hz, 6H), 0.95 (s, 9H). LCMS: RT=2.479 min, m/z 1246.9 [M+H]⁺.

### Example B-53. Synthesis of (2S,4R)-1-[(2S)-2-[(1-fluorocyclopropanecarbonyl)amino]-3,3-dimethyl-butanoyl]-N-[[2-[9-[4-[5-[2-fluoro-5-[[4-fluoro-2-(trifluoromethyl)benzoyl]amino]-4-[(3R,5S)-3,4,5-trimethylpiperazin-1-yl]phenyl]pyrimidin-2-yl]piperazin-1-yl]-9-oxo-nonoxy]-4-(4-methylthiazol-5-yl)phenyl]methyl]-4-hydroxy-pyrrolidine-2-carboxamide

The title compound was prepared using general procedures described for (2S,4R)-1-[(2S)-2-[(1-fluorocyclopropanecarbonyl)amino]-3,3-dimethyl-butanoyl]-N-[[2-[7-[4-[5-[2-fluoro-5-[[4-fluoro-2-(trifluoromethyl)benzoyl]amino]-4-[(3R,5S)-3,4,5-trimethylpiperazin-1-yl]phenyl]pyrimidin-2-yl]piperazin-1-yl]-7-oxo-heptoxy]-4-(4-methylthiazol-5-yl)phenyl]methyl]-4-hydroxy-pyrrolidine-2-carboxamide. ¹H NMR: DMSO-d₆, 400 MHz. δ 9.70 (s, 1H), 8.97 (s, 1H), 8.53 (s, 2H), 8.48 (t, J=6.8 Hz, 1H), 7.84-7.70 (m, 4H), 7.40 (d, J=7.6 Hz, 1H), 7.21-7.26 (m, 1H), 7.13-7.06 (m, 1H), 7.00 (d, J=4.0 Hz, 1H), 6.96-6.93 (m, 1H), 5.16 (d, J=3.6 Hz, 1H), 4.59 (d, J=8.8 Hz, 1H), 4.51 (t, J=8.8 Hz, 1H), 4.36-4.19 (m, 3H), 4.07-4.03 (m, 2H), 3.83-3.75 (m, 4H), 3.64-3.53 (m, 6H), 3.10-3.01 (m, 2H), 2.47-2.44 (m, 6H), 2.38-2.32 (m, 4H), 2.26-2.18 (m, 2H), 2.10-2.08 (m, 1H), 1.97-1.90 (m, 1H), 1.79-1.73 (m, 2H), 1.55-1.44 (m, 4H), 1.38-1.31 (m, 8H), 1.24-1.20 (m, 2H), 1.09-1.00 (m, 6H), 0.95 (s, 9H). LCMS: RT=2.537 min, m/z 1260.9 [M+H]f.

### Example B-54. Synthesis of (2S,4R)-1-[(2S)-2-[(1-fluorocyclopropanecarbonyl)amino]-3,3-dimethyl-butanoyl]-N-[[2-[10-[4-[5-[2-fluoro-5-[[4-fluoro-2-(trifluoromethyl)benzoyl]amino]-4-[(3R,5S)-3,4,5-trimethylpiperazin-1-yl]phenyl]pyrimidin-2-yl]piperazin-1-yl]-10-oxo-decoxy]-4-(4-methylthiazol-5-yl)phenyl]methyl]-4-hydroxy-pyrrolidine-2-carboxamide

The title compound was prepared using general procedures described for (2S,4R)-1-[(2S)-2-[(1-fluorocyclopropanecarbonyl)amino]-3,3-dimethyl-butanoyl]-N-[[2-[7-[4-[5-[2-fluoro-5-[[4-fluoro-2-(trifluoromethyl)benzoyl]amino]-4-[(3R,5S)-3,4,5-trimethylpiperazin-1-yl]phenyl]pyrimidin-2-yl]piperazin-1-yl]-7-oxo-heptoxy]-4-(4-methylthiazol-5-yl)phenyl]methyl]-4-hydroxy-pyrrolidine-2-carboxamide. HNMR: DMSO-d₆, 400 MHz. δ 9.69 (s, 1H), 8.99 (s, 1H), 8.56-8.51 (m, 2H), 8.50-8.45 (m, 1H), 7.87-7.67 (m, 4H), 7.42-7.38 (m, 1H), 7.31-7.25 (m, 1H), 7.12-7.06 (m, 1H), 7.01-6.98 (m, 1H), 6.96-6.91 (m, 1H), 5.19-5.12 (m, 1H), 4.62-4.56 (m, 1H), 4.55-4.47 (m, 1H), 4.38-4.12 (m, 3H), 4.08-3.99 (m, 2H), 3.87-3.72 (m, 4H), 3.68-3.48 (m, 6H), 3.10-2.97 (m, 2H), 2.48-2.44 (m, 6H), 2.37-2.31 (m, 4H), 2.21-2.16 (m, 2H), 2.12-2.04 (m, 1H), 1.98-1.89 (m, 1H), 1.79-1.70 (m, 2H), 1.54-1.42 (m, 4H), 1.38-1.27 (m, 10H), 1.25-1.19 (m, 2H), 1.08-0.98 (m, 6H), 0.95 (s, 9H). LCMS: RT=2.609 min, m/z 1274.9 [M+H]⁺.

### Example B-55. Synthesis of (2S,4R)-1-[(2S)-2-[(1-fluorocyclopropanecarbonyl)amino]-3,3-dimethyl-butanoyl]-N-[[2-[11-[4-[5-[2-fluoro-5-[[4-fluoro-2-(trifluoromethyl)benzoyl]amino]-4-[(3R,5S)-3,4,5-trimethylpiperazin-1-yl]phenyl]pyrimidin-2-yl]piperazin-1-yl]-11-oxo-undecoxy]-4-(4-methylthiazol-5-yl)phenyl]methyl]-4-hydroxy-pyrrolidine-2-carboxamide

The title compound was prepared using general procedures described for (2S,4R)-1-[(2S)-2-[(1-fluorocyclopropanecarbonyl)amino]-3,3-dimethyl-butanoyl]-N-[[2-[7-[4-[5-[2-fluoro-5-[[4-fluoro-2-(trifluoromethyl)benzoyl]amino]-4-[(3R,5S)-3,4,5-trimethylpiperazin-1-yl]phenyl]pyrimidin-2-yl]piperazin-1-yl]-7-oxo-heptoxy]-4-(4-methylthiazol-5-yl)phenyl]methyl]-4-hydroxy-pyrrolidine-2-carboxamide. ¹H NMR: DMSO-d₆, 400 MHz. δ 9.68 (s, 1H), 8.97 (s, 1H), 8.53 (s, 2H), 8.47 (t, J=6.0 Hz, 1H), 7.84-7.68 (m, 4H), 7.39 (d, J=7.6 Hz, 1H), 7.29-7.27 (m, 1H), 7.08 (d, J=12.4 Hz, 1H), 6.99 (s, 1H), 6.96-6.92 (m, 1H), 5.16 (s, 1H), 4.60-4.58 (m, 1H), 4.51 (t, J=8.0 Hz, 1H), 4.36-4.15 (m, 3H), 4.05-4.03 (m, 2H), 3.83-3.81 (m, 2H), 3.77-3.75 (m, 2H), 3.68-3.60 (m, 2H), 3.59-3.52 (m, 5H), 3.04-3.02 (m, 2H), 2.47-2.43 (m, 4H), 2.37-2.30 (m, 4H), 2.18 (s, 3H), 2.12-2.05 (m, 1H), 1.97-1.88 (m, 1H), 1.79-1.70 (m, 2H), 1.55-1.43 (m, 4H), 1.41-1.32 (m, 4H), 1.30-1.27 (m, 8H), 1.22-1.20 (m, 2H), 1.01 (d, J=6.0 Hz, 6H), 0.97-0.93 (m, 9H). LCMS: RT=2.680 min, m/z 1288.9 [M+H]⁺.

### Example B-56. Synthesis of (2S,4R)-1-[(2S)-2-[(1-fluorocyclopropanecarbonyl)amino]-3,3-dimethyl-butanoyl]-N-[[2-[12-[4-[5-[2-fluoro-5-[[4-fluoro-2-(trifluoromethyl)benzoyl]amino]-4-[(3S,5R)-3,4,5-trimethylpiperazin-1-yl]phenyl]pyrimidin-2-yl]piperazin-1-yl]-12-oxo-dodecoxy]-4-(4-methylthiazol-5-yl)phenyl]methyl]-4-hydroxy-pyrrolidine-2-carboxamide

The title compound was prepared using general procedures described for (2S,4R)-1-[(2S)-2-[(1-fluorocyclopropanecarbonyl)amino]-3,3-dimethyl-butanoyl]-N-[[2-[7-[4-[5-[2-fluoro-5-[[4-fluoro-2-(trifluoromethyl)benzoyl]amino]-4-[(3R,5S)-3,4,5-trimethylpiperazin-1-yl]phenyl]pyrimidin-2-yl]piperazin-1-yl]-7-oxo-heptoxy]-4-(4-methylthiazol-5-yl)phenyl]methyl]-4-hydroxy-pyrrolidine-2-carboxamide. HNMR: DMSO-d₆, 400 MHz. δ 9.70 (s, 1H), 8.97 (s, 1H), 8.54-8.52 (m, 2H), 8.49-8.43 (m, 1H), 7.85-7.70 (m, 4H), 7.39 (d, J=8.0 Hz, 1H), 7.32-7.25 (m, 1H), 7.13-7.07 (m, 1H), 6.99-6.93 (m, 2H), 5.16 (d, J=3.6 Hz, 1H), 4.62-4.48 (m, 2H), 4.36-4.16 (m, 3H), 4.05-4.01 (m, 2H), 3.88-3.47 (m, 12H), 3.12-3.01 (m, 2H), 2.45 (s, 3H), 2.37-2.33 (m, 3H), 2.25-2.18 (m, 2H), 2.10-2.05 (m, 1H), 1.95-1.89 (m, 1H), 1.77-1.72 (m, 2H), 1.52-1.42 (m, 4H), 1.35-1.20 (m, 20H), 1.06-1.01 (m, 4H), 0.95 (s, 9H). LCMS: RT=1.962 min, m/z 1303.5 [M+H]⁺.

### Example B-57. Synthesis of (2S,4R)-1-[(2S)-2-[(1-fluorocyclopropanecarbonyl)amino]-3,3-dimethyl-butanoyl]-N-[[2-[4-[4-[2-[4-[5-[2-fluoro-5-[[4-fluoro-2-(trifluoromethyl)benzoyl]amino]-4-[(3R,5S)-3,4,5-trimethylpiperazin-1-yl]phenyl]pyrimidin-2-yl]piperazin-1-yl]-2-oxo-ethyl]piperazin-1-yl]pentoxy]-4-(4-methylthiazol-5-yl)phenyl]methyl]-4-hydroxy-pyrrolidine-2-carboxamide

The title compound was prepared using general procedures described for (2S,4R)-1-[(2S)-2-[(1-fluorocyclopropanecarbonyl)amino]-3,3-dimethyl-butanoyl]-N-[[2-[7-[4-[5-[2-fluoro-5-[[4-fluoro-2-(trifluoromethyl)benzoyl]amino]-4-[(3R,5S)-3,4,5-trimethylpiperazin-1-yl]phenyl]pyrimidin-2-yl]piperazin-1-yl]-7-oxo-heptoxy]-4-(4-methylthiazol-5-yl)phenyl]methyl]-4-hydroxy-pyrrolidine-2-carboxamide. ¹H NMR: DMSO-d₆, 400 MHz. δ 9.69 (s, 1H), 8.98 (s, 1H), 8.54 (s, 2H), 8.48 (t, J=6.4 Hz, 1H), 7.84-7.71 (m, 4H), 7.40 (d, J=8.0 Hz, 1H), 7.32-7.24 (m, 1H), 7.09 (d, J=12.0 Hz, 1H), 7.00 (s, 1H), 6.97-6.92 (m, 1H), 5.17 (d, J=3.6 Hz, 1H), 4.62-4.58 (m, 1H), 4.53-4.51 (m, 1H), 4.39-4.19 (m, 3H), 4.08-4.06 (m, 2H), 3.88-3.75 (m, 4H), 3.70-3.54 (m, 6H), 3.36 (s, 3H), 3.17 (s, 2H), 3.06-3.04 (m, 2H), 2.48-2.45 (m, 6H), 2.44-2.41 (m, 2H), 2.36-2.29 (m, 6H), 2.18 (s, 3H), 2.12-2.05 (m, 1H), 1.97-1.90 (m, 1H), 1.81-1.73 (m, 2H), 1.64-1.56 (m, 2H), 1.41-1.33 (m, 2H), 1.24-1.20 (m, 2H), 1.02 (d, J=6.0 Hz, 6H), 0.98-0.93 (m, 9H). LCMS: RT=2.068 min, m/z 1303.0 [M+H]⁺.

### Example B-58. Synthesis of (2S,4R)-1-[(2S)-2-[(1-fluorocyclopropanecarbonyl)amino]-3,3-dimethyl-butanoyl]-N-[[2-[5-[4-[2-[4-[5-[2-fluoro-5-[[4-fluoro-2-(trifluoromethyl)benzoyl]amino]-4-[(3R,5S)-3,4,5-trimethylpiperazin-1-yl]phenyl]pyrimidin-2-yl]piperazin-1-yl]-2-oxo-ethyl]piperazin-1-yl]pentoxy]-4-(4-methylthiazol-5-yl)phenyl]methyl]-4-hydroxy-pyrrolidine-2-carboxamide

The title compound was prepared using general procedures described for (2S,4R)-1-[(2S)-2-[(1-fluorocyclopropanecarbonyl)amino]-3,3-dimethyl-butanoyl]-N-[[2-[7-[4-[5-[2-fluoro-5-[[4-fluoro-2-(trifluoromethyl)benzoyl]amino]-4-[(3R,5S)-3,4,5-trimethylpiperazin-1-yl]phenyl]pyrimidin-2-yl]piperazin-1-yl]-7-oxo-heptoxy]-4-(4-methylthiazol-5-yl)phenyl]methyl]-4-hydroxy-pyrrolidine-2-carboxamide. ¹H NMR: DMSO-d₆, 400 MHz. δ 9.73 (s, 1H), 8.98 (s, 1H), 8.60-8.47 (m, 3H), 7.86-7.69 (m, 4H), 7.40 (d, J=7.6 Hz, 1H), 7.29 (d, J=9.2 Hz, 11H), 7.12 (d, J=11.2 Hz, 1H), 7.02-6.92 (m, 2H), 5.18 (s, 11H), 4.59 (d, J=10.0 Hz, 1H), 4.54-4.47 (m, 1H), 4.39-4.13 (m, 4H), 4.09-4.01 (m, 2H), 3.85-3.75 (m, 4H), 3.64-3.52 (m, 10H), 3.13-3.05 (m, 4H), 2.69-2.65 (m, 4H), 2.48-2.44 (m, 6H), 2.33 (s, 3H), 2.13-2.03 (m, 2H), 1.99-1.87 (m, 2H), 1.81-1.73 (m, 2H), 1.61-1.54 (m, 2H), 1.50-1.43 (m, 2H), 1.40-1.33 (m, 2H), 1.23-1.17 (m, 2H), 1.10-1.06 (m, 6H), 0.95 (s, 9H). LCMS: RT=2.080 min, m/z 1316.9 [M+H]⁺.

### Example B-59. Synthesis of N-(4-fluoro-5-(2-(4-(10-(((S)-1-((2S,4R)-4-hydroxy-2-((4-(4-methylthiazol-5-yl)benzyl)carbamoyl)pyrrolidin-1-yl)-3,3-dimethyl-1-oxobutan-2-yl)amino)-10-oxodecanoyl)piperazin-1-yl)pyrimidin-5-yl)-2-((3R,5S)-3,4,5-trimethylpiperazin-1-yl)phenyl)-6-oxo-4-(trifluoromethyl)-1,6-dihydropyridine-3-carboxamide

The title compound was prepared using general procedures described for (2S,4R)-1-((S)-2-(10-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-10-oxodecanamido)-3,3-dimethylbutanoyl)-4-hydroxy-N—((S)-1-(4-(4-methylthiazol-5-yl)phenyl)ethyl)pyrrolidine-2-carboxamide. ¹H NMR: CD₃OD-d₄, 400 MHz. δ 8.86 (s, 1H), 8.56-8.53 (m, 2H), 7.97 (s, 1H), 7.90 (d, J=8.4 Hz, 1H), 7.80 (d, J=8.8 Hz, 1H), 7.48-7.44 (m, 2H), 7.43-7.38 (m, 2H), 7.12 (d, J=12.0 Hz, 1H), 6.93 (s, 1H), 4.64-4.62 (m, 1H), 4.60-4.56 (m, 3H), 4.52-4.50 (m, 1H), 4.38-4.32 (m, 1H), 3.94-3.88 (m, 3H), 3.87-3.78 (m, 3H), 3.70-3.57 (m, 5H), 3.17-3.12 (m, 2H), 2.94-2.83 (m, 2H), 2.77-2.70 (m, 2H), 2.58 (s, 3H), 2.47-2.46 (m, 3H), 2.32-2.19 (m, 3H), 2.12-2.03 (m, 1H), 1.67-1.58 (m, 4H), 1.39-1.32 (m, 8H), 1.28-1.23 (m, 6H), 1.03 (s, 9H). LCMS: RT=2.026 min, m/z 1185.8 [M+H]⁺.

### Example B-60. Synthesis of N-(4-fluoro-5-(2-(4-(10-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)amino)-10-oxodecanoyl)piperazin-1-yl)pyrimidin-5-yl)-2-((3R,5S)-3,4,5-trimethylpiperazin-1-yl)phenyl)-6-oxo-4-(trifluoromethyl)-1,6-dihydropyridine-3-carboxamide

The title compound was prepared using general procedures described for (2S,4R)-1-((S)-2-(10-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-10-oxodecanamido)-3,3-dimethylbutanoyl)-4-hydroxy-N—((S)-1-(4-(4-methylthiazol-5-yl)phenyl)ethyl)pyrrolidine-2-carboxamide. ¹H NMR: MeOD-d₄, 400 MHz. δ 8.86 (s, 1H), 8.56-8.54 (m, 2H), 7.96 (s, 1H), 7.90 (d, 0.1=8.0 Hz, 1H), 7.79 (d, J=8.8 Hz, 1H), 7.46-7.38 (m, 4H), 7.10 (d, J=12.0 Hz, 1H), 6.92 (s, 1H), 5.04-4.98 (m, 1H), 4.63-4.58 (m, 3H), 4.45-4.41 (m, 1H), 3.95-3.83 (m, 5H), 3.78-3.71 (m, 1H), 3.71-3.63 (m, 4H), 3.63-3.54 (m, 1H), 3.14-3.06 (m, 2H), 2.75-2.63 (m, 4H), 2.48-2.46 (m, 6H), 2.33-2.23 (m, 2H), 2.22-2.15 (m, 1H), 2.01-1.91 (m, 1H), 1.65-1.56 (m, 4H), 1.50 (d, J=7.2 Hz, 3H), 1.41-1.32 (m, 8H), 1.23-1.18 (m, 6H), 1.07-1.00 (m, 9H). LCMS: RT=1.662 min, m/z 1199.8 [M+H]⁺.

### Example B-61. Synthesis of (2S,4R)-1-((2S)-2-(2-(4-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethoxy)-2-methylbutoxy)acetamido)-3,3-dimethylbutanoyl)-4-hydroxy-N—((S)-1-(4-(4-methylthiazol-5-yl)phenyl)ethyl)pyrrolidine-2-carboxamide

### A. Step 1

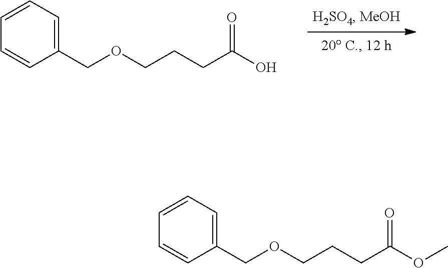

To a solution of 4-benzyloxybutanoic acid (7 g, 36.04 mmol) in MeOH (70 mL) was added H₂SO₄ (2.15 g, 21.89 mmol) at 20° C., then the reaction mixture was stirred at 20° C. for 12 hours under N₂ protection. The reaction mixture was adjusted pH to 8-9 by addition of NaHCO₃ solution. The solvent was removed in vacuo. Ethyl acetate (100 mL) and water (200 mL) were added and layers were separated. The aqueous phase was extracted with ethyl acetate (100 mL×2). Combined extracts were washed with brine (100 mL), dried over Na₂SO₄, filtered, and concentrated in vauco. Methyl 4-(benzyloxy)butanoate (7.5 g, 36.01 mmol, 99.93% yield) was obtained as colorless oil. ¹H NMR: CDCl₃, 400 MHz. δ 7.47-7.23 (m, 5H), 4.52 (s, 2H), 3.67 (s, 3H), 3.53 (t, J=6.4 Hz, 2H), 2.46 (t, J=7.0 Hz, 2H), 2.01-1.90 (m, 2H).

### B. Step 2

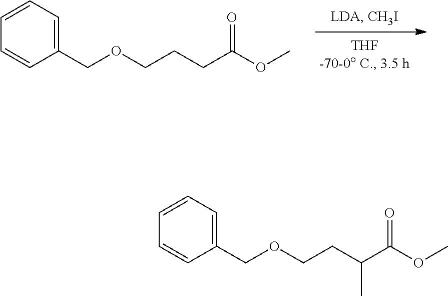 [SMILES: COC(=O)CCCOCc1ccccc1 ; COC(=O)C(C)CCOCc1ccccc1]

To a solution of methyl 4-(benzyloxy)butanoate (4 g, 19.21 mmol) in THE (40 mL) was added LDA (2 M, 14.41 mL) dropwise at −70° C. and the reaction mixture was stirred for 0.5 hour under N₂ protection. Then to this solution was added CH₃I (2.74 g, 19.28 mmol) and the resulting mixture was warmed to 0° C. and stirred for 3 hours. The reaction mixture was quenched by addition of sat.NH₄Cl solution (5 mL). Ethyl acetate (80 mL) and water (100 mL) were added and the layers were separated. The aqueous phase was extracted with ethyl acetate (50 mL×2). Combined extracts were washed with brine (60 mL), dried over Na₂SO₄, filtered, and concentrated in vacuo. The residue was purified by silica gel chromatography (Petroleum ether:Ethyl acetate=1:0 to 10:1) to give methyl 4-(benzyloxy)-2-methylbutanoate (1.4 g, 6.30 mmol, 32.79% yield) as colorless oil. ¹H NMR: CDCl₃, 400 MHz. δ 7.37-7.29 (m, 5H), 4.49 (s, 2H), 3.65 (s, 3H), 3.54-3.48 (m, 2H), 2.75-2.60 (m, 1H), 2.10-1.99 (m, 1H), 1.75-1.68 (m, 1H), 1.18 (d, J=6.8 Hz, 3H).

### C. Step 3

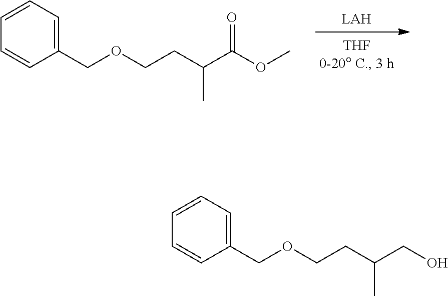 [SMILES: COC(=O)C(C)CCOCc1ccccc1 ; CC(CO)CCOCc1ccccc1]

To a solution of LAH (2.5 M, 5.04 mL, 2 eq) in THF (10 mL) was added methyl 4-(benzyloxy)-2-methylbutanoate (1.4 g, 6.30 mmol) dropwise as a solution in THE (5 mL) at 0° C. for 5 mins under N₂ protection. Then the reaction mixture was warmed to 20° C. and stirred for 3 hours. The reaction mixture was quenched by addition of H₂O (0.6 mL) and 15% NaOH solution (0.6 mL) at 0° C. To this solution was added Na₂SO₄ (10 g), the mixture was filtered and the solid was washed with ethyl acetate (20 mL). The filtrate was concentrated in vacuo. Compound 4-(benzyloxy)-2-methylbutan-1-ol (1.1 g, 5.66 mmol, 89.90% yield) was obtained as colorless oil. ¹H NMR: CDCl₃, 400 MHz. δ 7.40-7.29 (m, 5H), 4.53 (s, 2H), 3.68-3.58 (m, 1H), 3.57-3.49 (m, 2H), 3.48-3.42 (m, 1H), 1.84-1.75 (m, 1H), 1.74-1.67 (m, 1H), 1.64-1.55 (m, 1H), 0.96-0.90 (m, 3H).

### D. Step 4

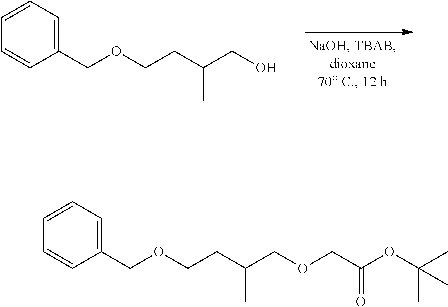 [SMILES: CC(CO)CCOCc1ccccc1 ; CC(CCOCc1ccccc1)COCC(=O)OC(C)(C)C]

To a solution of 4-(benzyloxy)-2-methylbutan-1-ol (0.5 g, 2.57 mmol), tert-butyl 2-bromoacetate (1.26 g, 6.43 mmol) in dioxane (10 mL) was added NaOH (308.83 mg, 7.72 mmol), TBAB (414.84 mg, 1.29 mmol) at 20° C., then the reaction mixture was heated to 70° C. and stirred for 12 hours. The reaction mixture was quenched by addition of sat.NH₄Cl solution (5 mL). Ethyl acetate (80 mL) and water (100 mL) were added and layers were separated. The aqueous phase was extracted with ethyl acetate (50 mL×2). Combined extracts were washed with brine (60 mL), dried over Na₂SO₄, filtered, and concentrated in vacuo. The residue was purified by silica gel chromatography (Petroleum ether:Ethyl acetate=1:0 to 10:1). Compound tert-butyl 2-(4-(benzyloxy)-2-methylbutoxy)acetate (0.22 g, 713.33 μmol, 27.72% yield) was obtained as colorless oil. ¹H NMR: CDCl₃, 400 MHz. δ 7.37-7.28 (m, 5H), 4.51 (s, 2H), 3.94 (s, 2H), 3.61-3.50 (m, 2H), 3.43-3.29 (m, 2H), 2.03-1.90 (m, 1H), 1.86-1.74 (m, 1H), 1.50-1.47 (m, 10H), 0.99-0.95 (m, 3H).

### E. Step 5

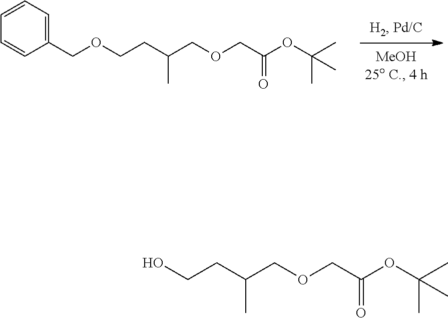 [SMILES: CC(CCOCc1ccccc1)COCC(=O)OC(C)(C)C ; CC(CCO)COCC(=O)OC(C)(C)C]

To a solution of tert-butyl 2-(4-(benzyloxy)-2-methylbutoxy)acetate (220 mg, 713.33 μmol) in MeOH (5 mL) was added Pd/C (0.1 g, 93.97 μmol, 10% purity) under N₂ protection.

The suspension was degassed under vacuum and purged with H₂ several times. The mixture was stirred under H₂ (30 psi) at 25° C. for 4 hours. The reaction mixture was filtered and the filtrate was concentrated in vacuo. Compound tert-butyl 2-(4-hydroxy-2-methylbutoxy)acetate (150 mg, 687.16 μmol, 96.33% yield) was obtained as colorless oil that was used into next step directly.

### F. Step 6

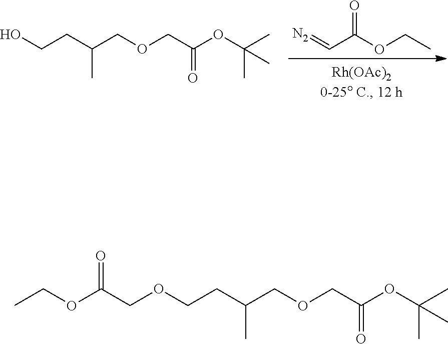

To a solution of tert-butyl 2-(4-hydroxy-2-methylbutoxy)acetate (200 mg, 916.22 mol), Rh(OAc)₂ (10.12 mg, 45.81 μmol) in CH₂Cl₂ (10 mL) was added ethyl 2-diazoacetate (313.63 mg, 2.75 mmol) at 0° C., then the reaction mixture was warmed to 25° C. and stirred for 12 hours. The reaction mixture was diluted with CH₂Cl₂ (20 mL) and washed with H₂O (15 mL×2). The organic layer was washed with brine (15 mL), dried over Na₂SO₄, filtered, and concentrated. The residue was purified by prep-TLC (Petroleum ether:Ethyl acetate=5:1). Compound tert-butyl 2-(4-(2-ethoxy-2-oxoethoxy)-2-methylbutoxy)acetate (220 mg, 361.39 μmol, 39.44% yield, 50% purity) was obtained as yellow oil. ¹H NMR: CDCl₃, 400 MHz. δ 4.23-4.18 (m, 2H), 4.06 (s, 2H), 3.94 (s, 2H), 3.64-3.57 (m, 2H), 3.42-3.33 (m, 2H), 1.99-1.87 (m, 1H), 1.85-1.75 (m, 1H), 1.48-1.43 (m, 10H), 1.29-1.27 (m, 3H), 0.98 (d, J=6.8 Hz, 3H).

### G. Step 7

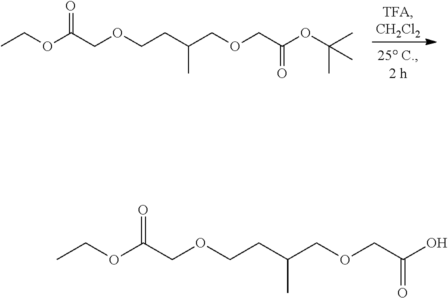

To a solution of tert-butyl 2-(4-(2-ethoxy-2-oxoethoxy)-2-methylbutoxy)acetate (220 mg, 361.39 μmol) in CH₂Cl₂ (3 mL) was added TFA (824.14 mg, 7.23 mmol) at 25° C. and stirred for 2 hours. The solvent was removed in vacuo to give the desired product 2-(4-(2-ethoxy-2-oxoethoxy)-2-methylbutoxy)acetic acid (178 mg, 358.48 μmol, 99.19% yield, 50% purity) as yellow oil that was used into next step directly.

### H. Step 8

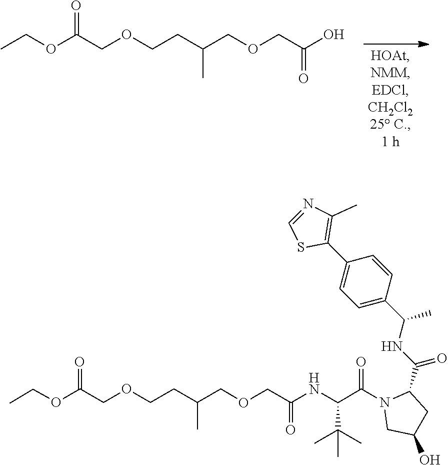 [SMILES: CCOC(=O)COCCC(C)COCC(=O)O ; CCOC(=O)COCCC(C)COCC(=O)N[C@H](C(=O)N1C[C@H](O)C[C@H]1C(=O)N[C@@H](C)c1ccc(-c2scnc2C)cc1)C(C)(C)C]

To a solution of 2-(4-(2-ethoxy-2-oxoethoxy)-2-methylbutoxy)acetic acid (178 mg, 358.48 μmol), NMM (145.04 mg, 1.43 mmol), HOAt (48.79 mg, 358.48 μmol) in CH₂Cl₂ (5 mL) was added EDCI (137.44 mg, 716.96 μmol) at 25° C., the reaction mixture was stirred for 30 mins. Then to this solution was added (2S,4R)-1-((S)-2-amino-3,3-dimethylbutanoyl)-4-hydroxy-N—((S)-1-(4-(4-methylthiazol-5-yl)phenyl)ethyl)pyrrolidine-2-carboxamide (159.38 mg, 358.48 μmol) and stirred for 0.5 hour The mixture was diluted with CH₂Cl₂ (20 mL) and washed with H₂O (15 mL×2). The organic layer was washed with brine (15 mL), dried over Na₂SO₄, filtered, and concentrated. The residue was purified by prep-TLC (CH₂Cl₂:MeOH=10:1). Compound ethyl 2-(4-(2-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)amino)-2-oxoethoxy)-3-methylbutoxy)acetate (120 mg, 165.37 μmol, 46.13% yield, 93% purity) was obtained as yellow oil. LCMS: RT=0.587 min, m/z 675.5 [M+H]⁺.

### I. Step 9

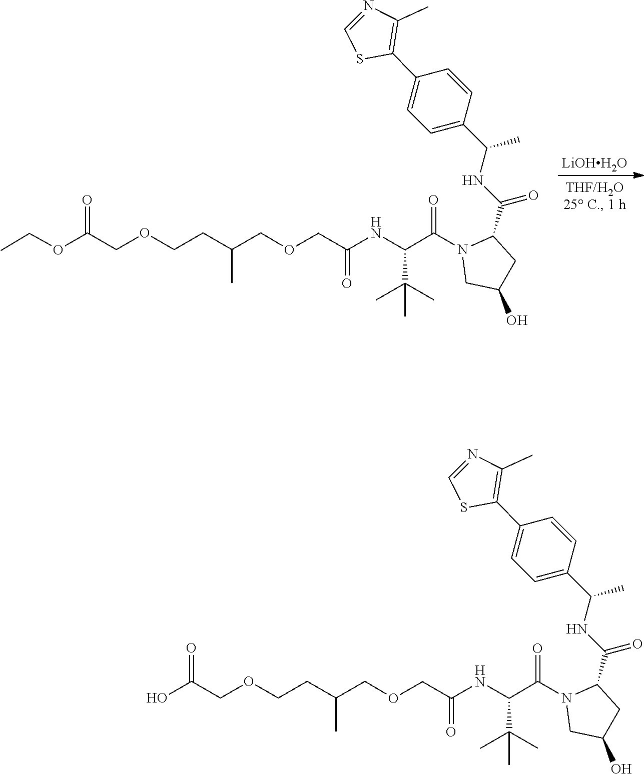 [SMILES: CCOC(=O)COCCC(C)COCC(=O)N[C@H](C(=O)N1C[C@H](O)C[C@H]1C(=O)N[C@@H](C)c1ccc(-c2scnc2C)cc1)C(C)(C)C ; "LiOH·H2O" ; Cc1ncsc1-c1ccc([C@H](C)NC(=O)[C@@H]2C[C@@H](O)CN2C(=O)[C@@H](NC(=O)COCC(C)CCOCC(=O)O)C(C)(C)C)cc1]

To a solution of ethyl 2-(4-(2-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)amino)-2-oxoethoxy)-3-methylbutoxy)acetate (120 mg, 165.37 μmol) in THE (5 mL)/120 (2 mL) was added LiOH H₂O (13.88 mg, 330.74 μmol) at 25° C., then the reaction mixture was stirred for 1 hour. The solvent THE was removed in vacuo. The aqueous phase was diluted with H₂O (20 mL), extracted with ethyl acetate (15 mL×2). The organic layer was discarded. Then the pH was adjusted to 4-5 with 2M HCl. The mixture was extracted with Ethyl acetate (20 mL×3). The combined organic layer was washed with brine (20 mL), dried over Na₂SO₄, filtered, and concentrated in vacuo. Compound 2-(4-(2-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)amino)-2-oxoethoxy)-3-methylbutoxy)acetic acid (0.1 g, 154.61 μmol, 93.49% yield) was obtained as yellow oil. LCMS: RT=0.534 min, m/z 647.5 [M+H]⁺.

### J. Step 10

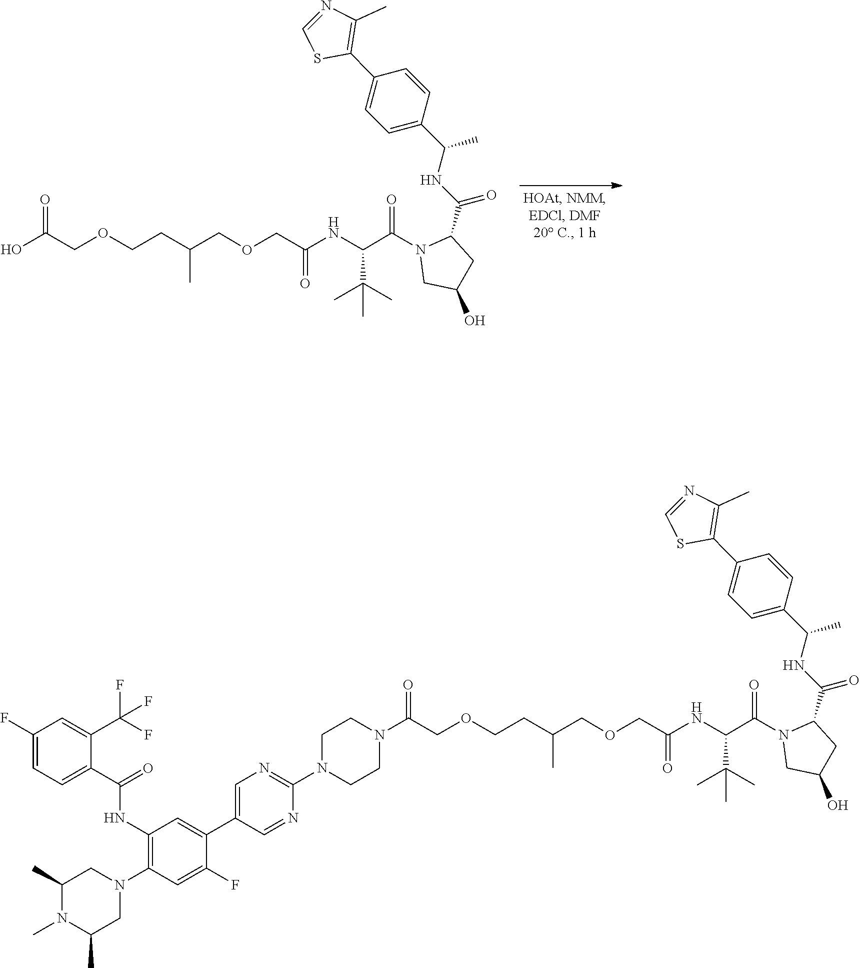 [SMILES: Cc1ncsc1-c1ccc([C@H](C)NC(=O)[C@@H]2C[C@@H](O)CN2C(=O)[C@@H](NC(=O)COCC(C)CCOCC(=O)O)C(C)(C)C)cc1 ; Cc1ncsc1-c1ccc([C@H](C)NC(=O)[C@@H]2C[C@@H](O)CN2C(=O)[C@@H](NC(=O)COCC(C)CCOCC(=O)N2CCN(c3ncc(-c4cc(NC(=O)c5ccc(F)cc5C(F)(F)F)c(N5C[C@@H](C)N(C)[C@@H](C)C5)cc4F)cn3)CC2)C(C)(C)C)cc1]

To a solution of 2-(4-(2-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)amino)-2-oxoethoxy)-3-methylbutoxy)acetic acid (50 mg, 77.30 μmol), NMM (31.28 mg, 309.22 μmol), HOAt (10.52 mg, 77.30 μmol) in DMF (2 mL) was added EDCI (29.64 mg, 154.61 μmol) at 20° C. The reaction mixture was stirred for 0.5 hour. Then to this solution was added 4-fluoro-N-(4-fluoro-5-(2-(piperazin-1-yl)pyrimidin-5-yl)-2-((3R,5S)-3,4,5-trimethylpiperazin-1-yl)phenyl)-2-(trifluoromethyl)benzamide (50.00 mg, 79.86 μmol, HCl) and stirred for 0.5 hour. The reaction mixture was concentrated in vacuo. The residue was purified by prep-HPLC (column: Phenomenex luna C18 150*25 mm*10 um; mobile phase: [water(FA)-ACN]; gradient: 23%-53% B over 10 min) to give the desired product (2S,4R)-1-((2S)-2-(2-(4-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethoxy)-2-methylbutoxy)acetamido)-3,3-dimethylbutanoyl)-4-hydroxy-N—((S)-1-(4-(4-methylthiazol-5-yl)phenyl)ethyl)pyrrolidine-2-carboxamide (51.27 mg, 42.08 μmol, 54.43% yield) as a white solid. ¹H NMR: MeOD-d₄, 400 MHz. δ 8.87-8.84 (m, 1H), 8.59-8.54 (m, 2H), 8.02 (d, J=8.4 Hz, 1H), 7.81-7.71 (m, 1H), 7.66-7.61 (m, 1H), 7.58-7.50 (m, 1H), 7.44-7.36 (m, 4H), 7.11 (d, J=12.0 Hz, 1H), 5.04-4.97 (m, 1H), 4.71-4.64 (m, 1H), 4.59-4.54 (m, 3H), 4.31-4.22 (m, 2H), 3.99-3.83 (m, 6H), 3.76-3.58 (m, 7H), 3.49-3.38 (m, 2H), 3.16-3.04 (m, 2H), 2.74-2.58 (m, 4H), 2.45 (s, 6H), 2.25-2.13 (m, 1H), 2.06-1.90 (m, 2H), 1.87-1.74 (m, 1H), 1.58-1.44 (m, 4H), 1.24-1.15 (m, 6H), 1.05-0.98 (m, 12H). LCMS: RT=1.764 min, m/z 1218.8 [M+H]⁺.

### Example B-62. Synthesis of N-(4-fluoro-5-(2-(4-(2-(4-(2-(((S)-1-((2S,4R)-4-hydroxy-2-(((S)-1-(4-(4-methylthiazol-5-yl)phenyl)ethyl)carbamoyl)pyrrolidin-1-yl)-3,3-dimethyl-1-oxobutan-2-yl)amino)-2-oxoethoxy)-3-methylbutoxy)acetyl)piperazin-1-yl)pyrimidin-5-yl)-2-((3R,5S)-3,4,5-trimethylpiperazin-1-yl)phenyl)-6-oxo-4-(trifluoromethyl)-1,6-dihydropyridine-3-carboxamide

The title compound was prepared using general procedures described for (2S,4R)-1-((2S)-2-(2-(4-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethoxy)-2-methylbutoxy)acetamido)-3,3-dimethylbutanoyl)-4-hydroxy-N—((S)-1-(4-(4-methylthiazol-5-yl)phenyl)ethyl)pyrrolidine-2-carboxamide. ¹H NMR: MeOD-d₄, 400 MHz. δ 8.89-8.84 (m, 1H), 8.58-8.53 (m, 2H), 7.96 (s, 1H), 7.91 (d, J=8.4 Hz, 1H), 7.45-7.34 (m, 4H), 7.11 (d, J=12.0 Hz, 1H), 6.92 (s, 1H), 5.02-4.98 (m, 1H), 4.64-4.52 (m, 3H), 4.43 (br s, 1H), 4.31-4.23 (m, 2H), 3.99-3.83 (m, 6H), 3.78-3.59 (m, 7H), 3.50-3.38 (m, 2H), 3.16-3.10 (m, 2H), 2.90-2.80 (m, 2H), 2.76-2.66 (m, 2H), 2.55 (s, 3H), 2.46 (s, 3H), 2.39-2.15 (m, 1H), 2.06-1.91 (m, 2H), 1.87-1.75 (m, 1H), 1.60-1.46 (m, 4H), 1.27-1.20 (m, 6H), 1.06-0.99 (m, 12H). LCMS: RT=1.94 min, m/z 1217.8 [M+H]⁺.

### Example B-63. Synthesis of (2S,4R)-1-((S)-2-(2-(4-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethoxy)-2,2-dimethylbutoxy)acetamido)-3,3-dimethylbutanoyl)-4-hydroxy-N—((S)-1-(4-(4-methylthiazol-5-yl)phenyl)ethyl)pyrrolidine-2-carboxamide

The title compound was prepared using general procedures described for (2S,4R)-1-((2S)-2-(2-(4-(2-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-2-oxoethoxy)-2-methylbutoxy)acetamido)-3,3-dimethylbutanoyl)-4-hydroxy-N—((S)-1-(4-(4-methylthiazol-5-yl)phenyl)ethyl)pyrrolidine-2-carboxamide. ¹H NMR: MeOD-d₄, 400 MHz δ 8.89-8.83 (m, 1H), 8.59-8.50 (m, 2H), 8.05-7.09 (m, 1H), 7.80-7.72 (m, 1H), 7.69-7.61 (m, 1H), 7.59-7.52 (m, 1H), 7.46-7.34 (m, 4H), 7.10 (d, J=12.0 Hz, 1H), 5.02-4.97 (m, 1H), 4.67 (s, 1H), 4.62-4.57 (m, 2H), 4.45-4.41 (m, 1H), 4.29-4.25 (m, 2H), 4.02-3.82 (m, 7H), 3.78-3.56 (m, 8H), 3.09-3.02 (m, 2H), 2.68-2.59 (m, 2H), 2.57-2.48 (m, 2H), 2.46 (s, 3H), 2.37 (s, 3H), 2.25-2.17 (m, 1H), 2.01-1.91 (m, 1H), 1.76-1.66 (m, 2H), 1.58-1.47 (m, 3H), 1.18-1.13 (m, 6H), 1.06-1.00 (m, 15H). LCMS: RT=1.869 min, m/z 1232.8 [M+H]⁺.

### Example B-64. Synthesis of (2S,4R)-1-((R)-2-(3-((6-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-6-oxohexyl)oxy)isoxazol-5-yl)-3-methylbutanoyl)-4-hydroxy-N—((S)-1-(4-(4-methylthiazol-5-yl)phenyl)ethyl)pyrrolidine-2-carboxamide

### A. Step 1

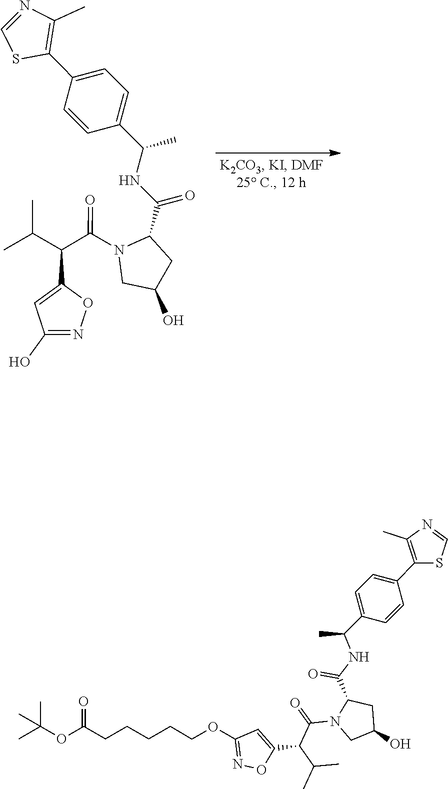 [SMILES: Cc1ncsc1-c1ccc([C@H](C)NC(=O)[C@@H]2C[C@@H](O)CN2C(=O)[C@@H](c2cc(O)no2)C(C)C)cc1 ; Cc1ncsc1-c1ccc([C@H](C)NC(=O)[C@@H]2C[C@@H](O)CN2C(=O)[C@@H](c2cc(OCCCCCC(=O)OC(C)(C)C)no2)C(C)C)cc1]

To a solution of (2S,4R)-4-hydroxy-1-((R)-2-(3-hydroxyisoxazol-5-yl)-3-methylbutanoyl)-N—((S)-1-(4-(4-methylthiazol-5-yl)phenyl)ethyl)pyrrolidine-2-carboxamide (110.00 mg, 220.62 μmol) and tert-butyl 6-bromohexanoate (83.12 mg, 330.93 μmol) in DMF (3 mL) was added K₂CO₃ (91.48 mg, 661.86 μmol) and KI (7.32 mg, 44.12 μmol). The mixture was stirred at 25° C. for 12 hours. The reaction mixture was diluted with ethyl acetate (3 mL) and water (5 mL). The mixture was extracted with ethyl acetate (3 mL*3). The combined organic layer was washed with brine (3 mL*2), dried with anhydrous Na₂SO₄, filtered, and concentrated. The residue was purified by prep-TLC (silica gel, CH₂Cl₂:MeOH=10:1). The crude product was purified by chiral SFC separation (column: DAICEL CHIRALPAK IK (250 mm*30 mm, 10 um); mobile phase: [CO₂-i-PrOH(0.1% NH₃·H₂O)]; B %: 55%, isocratic elution mode) to give the desired product tert-butyl 6-((5-((R)-1-((2S,4R)-4-hydroxy-2-(((S)-1-(4-(4-methylthiazol-5-yl)phenyl)ethyl)carbamoyl)pyrrolidin-1-yl)-3-methyl-1-oxobutan-2-yl)isoxazol-3-yl)oxy)hexanoate (65 mg, 97.18 μmol, 44.05% yield) as a white solid. ¹H NMR: MeOD-d₄, 400 MHz. δ 8.87 (s, 1H), 7.54-7.32 (m, 4H), 6.05-5.89 (m, 1H), 5.10-4.95 (m, 1H), 4.62-4.50 (m, 2H), 4.47-4.37 (m, 1H), 4.24-4.08 (m, 2H), 3.77-3.54 (m, 2H), 2.48 (s, 3H), 2.42-2.13 (m, 4H), 2.08-1.91 (m, 1H), 1.85-1.71 (m, 2H), 1.65-1.59 (m, 2H), 1.54-1.51 (m, 2H), 1.51-1.38 (m, 11H), 1.10-1.00 (m, 3H), 0.95-0.86 (m, 3H). LCMS: RT=0.610 min, m/z 669.4 [M+H]⁺.

### B. Step 2

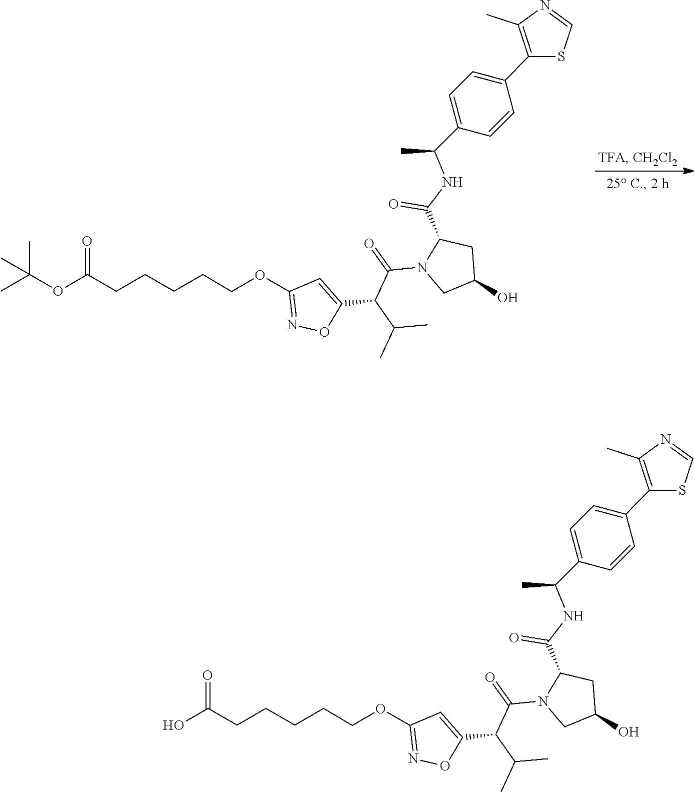 [SMILES: Cc1ncsc1-c1ccc([C@H](C)NC(=O)[C@@H]2C[C@@H](O)CN2C(=O)[C@@H](c2cc(OCCCCCC(=O)OC(C)(C)C)no2)C(C)C)cc1 ; Cc1ncsc1-c1ccc([C@H](C)NC(=O)[C@@H]2C[C@@H](O)CN2C(=O)[C@@H](c2cc(OCCCCCC(=O)O)no2)C(C)C)cc1]

To a solution of tert-butyl 6-((5-((R)-1-((2S,4R)-4-hydroxy-2-(((S)-1-(4-(4-methylthiazol-5-yl)phenyl)ethyl)carbamoyl)pyrrolidin-1-yl)-3-methyl-1-oxobutan-2-yl)isoxazol-3-yl)oxy)hexanoate (65 mg, 97.18 μmol) in CH₂Cl₂ (1 mL) was added TFA (921.00 mg, 8.08 mmol, 0.6 mL). The mixture was stirred at 25° C. for 2 hours The reaction mixture was concentrated in vacuo. The crude product was purified by prep-HPLC (column: Waters xbridge 150*25 mm 10 um; mobile phase: [water(NH₄HCO₃)-ACN]; gradient: 18%-38% B over 8 min) to give 6-((5-((R)-1-((2S,4R)-4-hydroxy-2-(((S)-1-(4-(4-methylthiazol-5-yl)phenyl)ethyl)carbamoyl)pyrrolidin-1-yl)-3-methyl-1-oxobutan-2-yl)isoxazol-3-yl)oxy)hexanoic acid (45 mg, 73.44 μmol, 75.57% yield) as a white solid. LCMS: RT=0.512 min, m/z 613.3 [M+H]⁺.

### C. Step 3

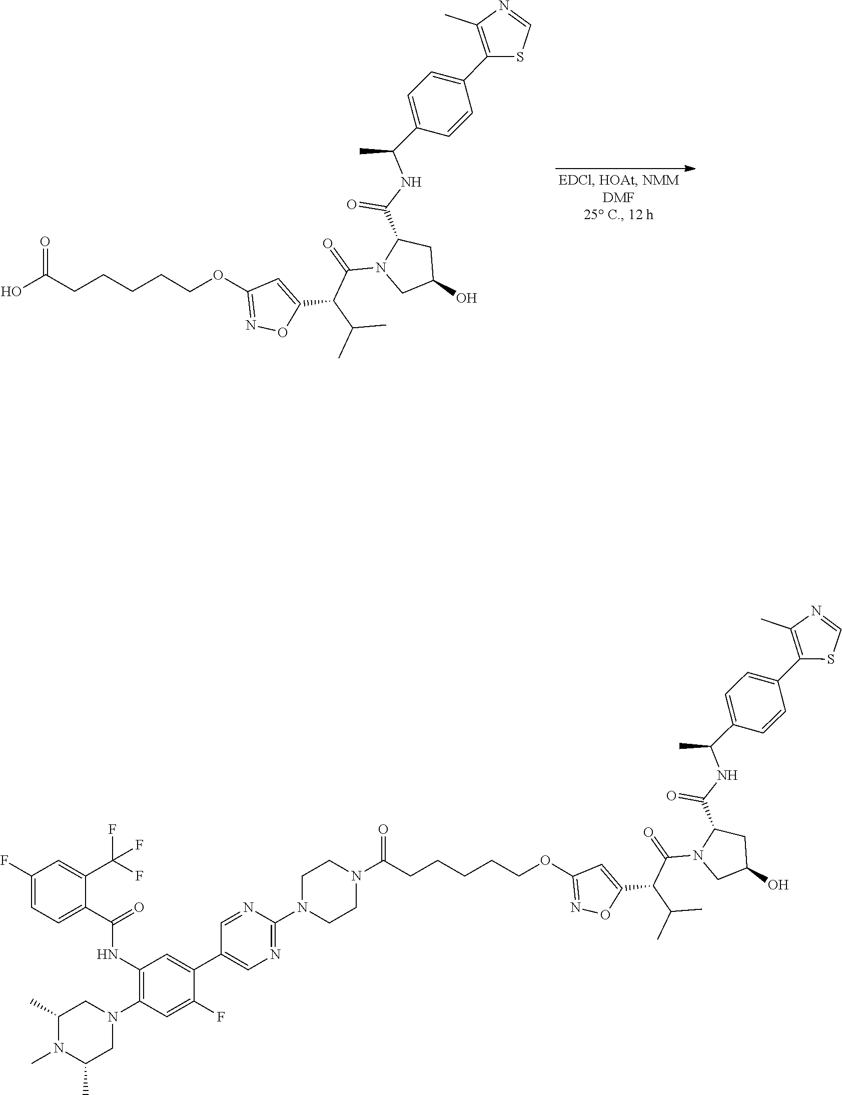 [SMILES: Cc1ncsc1-c1ccc([C@H](C)NC(=O)[C@@H]2C[C@@H](O)CN2C(=O)[C@@H](c2cc(OCCCCCC(=O)O)no2)C(C)C)cc1 ; Cc1ncsc1-c1ccc([C@H](C)NC(=O)[C@@H]2C[C@@H](O)CN2C(=O)[C@@H](c2cc(OCCCCCC(=O)N3CCN(c4ncc(-c5cc(NC(=O)c6ccc(F)cc6C(F)(F)F)c(N6C[C@@H](C)N(C)[C@@H](C)C6)cc5F)cn4)CC3)no2)C(C)C)cc1]

To a solution of 6-((5-((R)-1-((2S,4R)-4-hydroxy-2-(((S)-1-(4-(4-methylthiazol-5-yl)phenyl)ethyl)carbamoyl)pyrrolidin-1-yl)-3-methyl-1-oxobutan-2-yl)isoxazol-3-yl)oxy)hexanoic acid (45 mg, 73.44 μmol) in DMF (1 mL) was added NMM (37.14 mg, 367.21 μmol, 40.37 μL), 4-fluoro-N-(4-fluoro-5-(2-(piperazin-1-yl)pyrimidin-5-yl)-2-((3R,5S)-3,4,5-trimethylpiperazin-1-yl)phenyl)-2-(trifluoromethyl)benzamide (59.77 mg, 95.47 μmol, HCl), HOAt (10.00 mg, 73.44 μmol) and EDCI (16.89 mg, 88.13 μmol). The mixture was stirred at 25° C. for 12 hours. The reaction mixture was concentrated in vacuo. The crude product was purified by prep-HPLC (column: Waters xbridge 150*25 mm 10 um; mobile phase: [water(NH₄HCO₃)-ACN]; gradient: 54%-74% B over 8 min) to give (2S,4R)-1-((R)-2-(3-((6-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-6-oxohexyl)oxy)isoxazol-5-yl)-3-methylbutanoyl)-4-hydroxy-N—((S)-1-(4-(4-methylthiazol-5-yl)phenyl)ethyl)pyrrolidine-2-carboxamide (34.01 mg, 28.59 μmol, 38.93% yield, 99.57% purity) as a pink solid. ¹H NMR: DMSO-d₆, 400 MHz. δ 9.70 (s, 1H), 8.98 (s, 1H), 8.54 (s, 2H), 8.42 (d, J=8.0 Hz, 1H), 7.84-7.67 (m, 4H), 7.49-7.32 (m, 4H), 7.08 (d, J=12.4 Hz, 1H), 6.10-6.02 (m, 1H), 5.19-5.06 (m, 1H), 4.95-4.87 (m, 1H), 4.40-4.33 (m, 1H), 4.30-4.24 (m, 1H), 4.21-4.09 (m, 3H), 3.86-3.73 (m, 6H), 3.72-3.67 (m, 2H), 3.65-3.61 (m, 2H), 3.58-3.57 (m, 2H), 3.06-2.98 (m, 2H), 2.45 (s, 4H), 2.42-2.35 (m, 2H), 2.30-2.28 (m, 1H), 2.27-2.21 (m, 1H), 2.17 (s, 3H), 2.09-1.96 (m, 1H), 1.81-1.68 (m, 3H), 1.63-1.51 (m, 2H), 1.48-1.40 (m, 2H), 1.39-1.32 (m, 3H), 1.04-0.99 (m, 6H), 0.98-0.91 (m, 3H), 0.85-0.74 (m, 3H). LCMS: RT=1.818 min, m/z 1184.7 [M+H]⁺.

### Example B-65. Synthesis of (2S,4R)-1-((R)-2-(3-((7-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-7-oxoheptyl)oxy)isoxazol-5-yl)-3-methylbutanoyl)-4-hydroxy-N—((S)-1-(4-(4-methylthiazol-5-yl)phenyl)ethyl)pyrrolidine-2-carboxamide

The title compound was prepared using general procedures described for (2S,4R)-1-((R)-2-(3-((6-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-6-oxohexyl)oxy)isoxazol-5-yl)-3-methylbutanoyl)-4-hydroxy-N—((S)-1-(4-(4-methylthiazol-5-yl)phenyl)ethyl)pyrrolidine-2-carboxamide. ¹H NMR: MeOD-d₄, 400 MHz. δ 8.89-8.84 (m, 1H), 8.58-8.53 (m, 2H), 8.04-7.99 (m, 1H), 7.80-7.74 (m, 1H), 7.68-7.61 (m, 1H), 7.59-7.52 (m, 1H), 7.48-7.34 (m, 4H), 7.09 (d, J=12.4 Hz, 1H), 6.01-5.95 (m, 1H), 5.01-4.97 (m, 1H), 4.58-4.57 (m, 3H), 4.22-4.11 (m, 2H), 3.95-3.85 (m, 4H), 3.77-3.64 (m, 7H), 3.10-2.98 (m, 2H), 2.67-2.57 (m, 2H), 2.50-2.43 (m, 7H), 2.36-2.19 (m, 4H), 2.07-1.54 (m, 6H), 1.53-1.33 (m, 7H), 1.15 (d, J=6.0 Hz, 6H), 1.07-0.94 (m, 3H), 0.93-0.82 (m, 3H). LCMS: RT=2.155 min, m/z 1220.6 [M+23]⁺.

### Example B-66. Synthesis of (2S,4R)-1-((R)-2-(3-((8-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-8-oxooctyl)oxy)isoxazol-5-yl)-3-methylbutanoyl)-4-hydroxy-N—((S)-1-(4-(4-methylthiazol-5-yl)phenyl)ethyl)pyrrolidine-2-carboxamide

The title compound was prepared using general procedures described for (2S,4R)-1-((R)-2-(3-((6-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-6-oxohexyl)oxy)isoxazol-5-yl)-3-methylbutanoyl)-4-hydroxy-N—((S)-1-(4-(4-methylthiazol-5-yl)phenyl)ethyl)pyrrolidine-2-carboxamide. ¹H NMR: CDCl₃, 400 MHz. δ 8.68 (s, 1H), 8.60-8.57 (m, 3H), 7.70-7.63 (m, 1H), 7.52-7.49 (m, 1H), 7.44-7.36 (m, 7H), 7.07-6.94 (m, 1H), 5.89 (s, 1H), 5.13-5.00 (m, 1H), 4.69-4.61 (m, 2H), 4.24-4.18 (m, 2H), 3.94-3.88 (m, 4H), 3.78-3.71 (m, 3H), 3.64-3.57 (m, 3H), 3.51-3.47 (m, 1H), 2.86-2.81 (m, 2H), 2.68-2.55 (m, 4H), 2.54 (s, 3H), 2.49-2.35 (m, 5H), 2.29 (s, 3H), 2.01-1.96 (m, 1H), 1.81-1.75 (m, 3H), 1.51-1.49 (m, 2H), 1.47-1.38 (m, 8H), 1.14-1.11 (m, 6H), 1.06-1.03 (m, 3H), 0.95-0.92 (m, 3H). LCMS: RT=1.949 min, m/z 1212.8 [M+H]⁺.

### Example B-67. Synthesis of (2S,4R)-1-((R)-2-(3-((9-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-9-oxononyl)oxy)isoxazol-5-yl)-3-methylbutanoyl)-4-hydroxy-N—((S)-1-(4-(4-methylthiazol-5-yl)phenyl)ethyl)pyrrolidine-2-carboxamide

The title compound was prepared using general procedures described for (2S,4R)-1-((R)-2-(3-((6-(4-(5-(2-fluoro-5-(4-fluoro-2-(trifluoromethyl)benzamido)-4-((3R,5S)-3,4,5-trimethylpiperazin-1-yl)phenyl)pyrimidin-2-yl)piperazin-1-yl)-6-oxohexyl)oxy)isoxazol-5-yl)-3-methylbutanoyl)-4-hydroxy-N—((S)-1-(4-(4-methylthiazol-5-yl)phenyl)ethyl)pyrrolidine-2-carboxamide. ¹H NMR: MeOD-d₄, 400 MHz. δ 8.93-8.81 (m, 1H), 8.63-8.51 (m, 2H), 8.01 (d, J=8.4 Hz, 1H), 7.79-7.73 (m, 1H), 7.67-7.62 (m, 1H), 7.59-7.52 (m, 1H), 7.47-7.33 (m, 4H), 7.09 (d, J=12.0 Hz, 1H), 6.05-5.94 (m, 1H), 5.03-4.96 (m, 1H), 4.59-4.53 (m, 3H), 4.45-4.40 (m, 1H), 4.22-4.10 (m, 2H), 4.02-3.96 (m, 1H), 3.95-3.90 (m, 2H), 3.89-3.84 (m, 2H), 3.77-3.63 (m, 6H), 3.07-3.00 (m, 2H), 2.62-2.57 (m, 2H), 2.49-2.37 (m, 7H), 2.32 (s, 3H), 2.25-2.17 (m, 1H), 2.00-1.91 (m, 1H), 1.80-1.69 (m, 2H), 1.68-1.56 (m, 2H), 1.52-1.31 (m, 10H), 1.20-1.15 (m, 6H), 1.07-0.94 (m, 3H), 0.93-0.83 (m, 3H). LCMS: RT=2.038 min, m/z 1226.8[M+H]⁺.

### Examples B-68 Through B-90

Synthesis of Examples B-68 through B-90 have been described previously in the following literature sources: WO2019/246,570, Journal of Medicinal Chemistry (2021), 64(15), 10682-10710; and/or Science Translational Medicine (2021), 13(613).

### Example C-1. Synthesis of 4-[(5-cyclopropyl-2-ethyl-pyrazol-3-yl)amino]-7-(3,5-dimethylisoxazol-4-yl)-N-[8-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-8-oxo-octyl]-6-methoxy-9H-pyrimido[4,5-B]indole-2-carboxamide

### A. Step 1

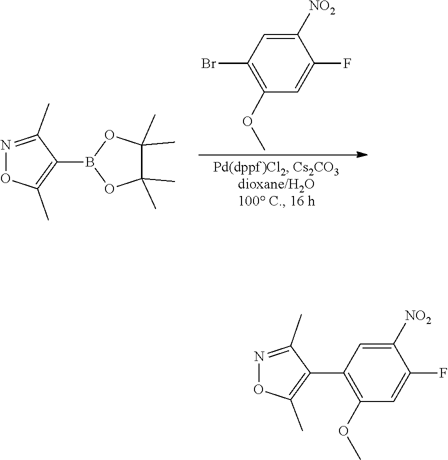 [SMILES: Cc1noc(C)c1B1OC(C)(C)C(C)(C)O1 ; COc1cc(F)c([N+](=O)[O-])cc1Br ; COc1cc(F)c([N+](=O)[O-])cc1-c1c(C)noc1C]

A mixture of 3,5-dimethyl-4-(4,4,5,5-tetramethyl-1,3,2-dioxaborolan-2-yl)isoxazole (20.34 g, 91.19 mmol), 1-bromo-4-fluoro-2-methoxy-5-nitro-benzene (19.0 g, 75.99 mmol), K₂CO₃ (31.51 g, 227.98 mmol) and Pd(dppf)Cl₂ (5.56 g, 7.60 mmol) in dioxane (140 mL) and H₂O (60 mL) was heated to 100° C. and stirred for 16 hours under N₂. The reaction mixture was diluted with water (150 mL). The mixture was extracted with ethyl acetate (200 mL×3). The combined organic phase was washed with brine (200 mL), dried with anhydrous Na₂SO₄, filtered and concentrated in vacuo. The residue was purified by column chromatography on silica gel (Petroleum ether/Ethyl acetate=1/1) to afford the desired product 4-(4-fluoro-2-methoxy-5-nitro-phenyl)-3,5-dimethyl-isoxazole (13.0 g, crude) as a yellow solid. LCMS: m/z 267.0 [M+H]

### B. Step 2

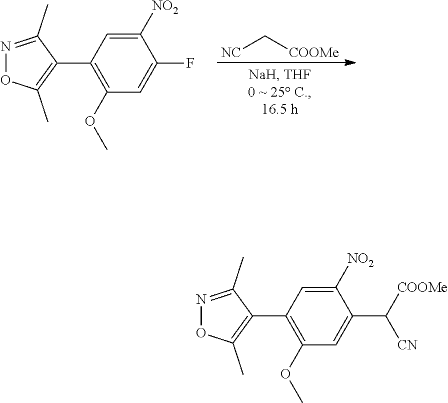 [SMILES: COc1cc(F)c([N+](=O)[O-])cc1-c1c(C)noc1C ; COC(=O)CC#N ; COC(=O)C(C#N)c1cc(OC)c(-c2c(C)noc2C)cc1[N+](=O)[O-]]

To a solution of methyl 2-cyanoacetate (5.81 g, 58.60 mmol, 5.17 mL) in THF (150 mL) was added NaH (3.91 g, 97.66 mmol, 60% purity in oil) at 0° C. under N₂. The mixture was stirred at 25° C. for 0.5 hour. To the mixture was added 4-(4-fluoro-2-methoxy-5-nitro-phenyl)-3,5-dimethyl-isoxazole (13 g, 48.83 mmol) at 0° C. under N₂. The mixture was stirred at 25° C. for 16 hours under N₂. The reaction mixture was quenched with saturated aqueous NH₄Cl solution (200 mL) and extracted with ethyl acetate (200 mL×3). The combined organic phase was washed with brine (200 mL), dried with anhydrous Na₂SO₄, filtered and concentrated in vacuo. The residue was purified by column chromatography on silica gel (Petroleum ether/Ethyl acetate=1/1) to afford the desired product methyl 2-cyano-2-[4-(3,5-dimethylisoxazol-4-yl)-5-methoxy-2-nitro-phenyl]acetate (13.0 g, 36.89 mmol, 75.56% yield, 98% purity) as a yellow oil. ¹H NMR: DMSO-d₆, 400 MHz. δ 8.23 (s, 1H), 7.51 (s, 1H), 6.24 (s, 1H), 3.97 (s, 3H), 3.78 (s, 3H), 2.32 (s, 3H), 2.12 (s, 3H). LCMS: RT=0.400 min, m/z 346.0 [M+H]⁺.

### C. Step 3

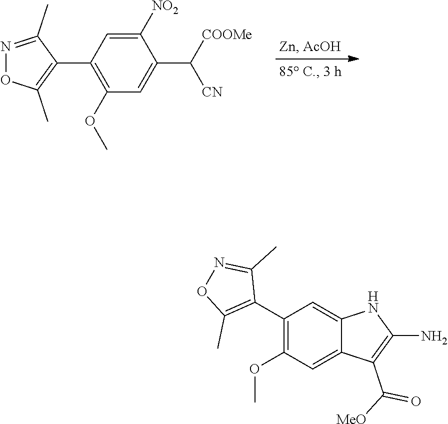 [SMILES: COC(=O)C(C#N)c1cc(OC)c(-c2c(C)noc2C)cc1[N+](=O)[O-] ; COC(=O)c1c(N)[nH]c2cc(-c3c(C)noc3C)c(OC)cc12]

To a solution of methyl 2-cyano-2-[4-(3,5-dimethylisoxazol-4-yl)-5-methoxy-2-nitro-phenyl]acetate (13 g, 37.65 mmol) in AcOH (100 mL) was added Zn (9.85 g, 150.59 mmol) at 25° C. under N₂. The mixture was heated to 85° C. and stirred for 3 hours. The reaction mixture was cooled, filtered, and washed with AcOH. The reaction mixture was diluted with water (50 mL). The mixture was extracted with ethyl acetate (100 mL×3). The combined organic phase was washed with brine (100 mL), dried with anhydrous Na₂SO₄, filtered and concentrated in vacuo. The residue was purified by column chromatography on silica gel (Petroleum ether/Ethyl acetate=2/1) to afford the desired product methyl 2-amino-6-(3,5-dimethylisoxazol-4-yl)-5-methoxy-1H-indole-3-carboxylate (5.3 g, 15.97 mmol, 42.41% yield, 95% purity) as a red solid. ¹H NMR: DMSO-d₆, 400 MHz. δ 10.48 (s, 1H), 7.25 (s, 1H), 6.89 (s, 1H), 6.70 (brs, 2H), 3.77 (s, 3H), 3.73 (s, 3H), 2.24 (s, 3H), 2.05 (s, 3H). LCMS: RT=0.409 min, m % z 316.0 [M+H]⁺.

### D. Step 4

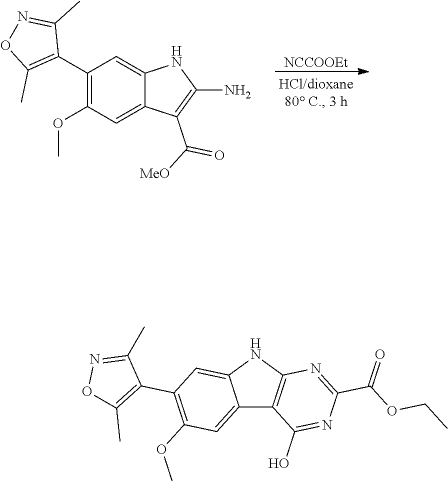 [SMILES: COC(=O)c1c(N)[nH]c2cc(-c3c(C)noc3C)c(OC)cc12 ; CCOC(=O)c1nc(O)c2c(n1)[nH]c1cc(-c3c(C)noc3C)c(OC)cc12 ; "NCCOOEt"]

A mixture of methyl 2-amino-6-(3,5-dimethylisoxazol-4-yl)-5-methoxy-1H-indole-3-carboxylate (500 mg, 1.59 mmol) and ethyl cyanoformate (1.57 g, 15.86 mmol, 1.55 mL) in HCl/dioxane (2 M in dioxane, 6.0 mmol, 3.0 mL) was heated to 80° C. and stirred for 3 hours under N₂. The reaction mixture was concentrated in vacuo. The mixture was triturated with Petroleum ether (100 mL). The resultant precipitate solid was collected by filtration and dried in vacuo to afford the desired product ethyl 7-(3,5-dimethylisoxazol-4-yl)-4-hydroxy-6-methoxy-9H-pyrimido[4,5-b]indole-2-carboxylate (5 g, crude, nine batch) as a yellow solid. ¹H NMR: DMSO-d₆, 400 MHz. δ 12.56 (brs, 1H), 12.47 (s, 1H), 7.64 (s, 1H), 7.34 (s, 1H), 4.39 (q, J=7.2 Hz, 2H), 3.85 (s, 3H), 2.29 (s, 3H), 2.09 (s, 3H), 1.37 (t, J=7.2 Hz, 3H). LCMS: RT=0.376 min, m/z 383.1 [M+H]⁺.

### E. Step 5

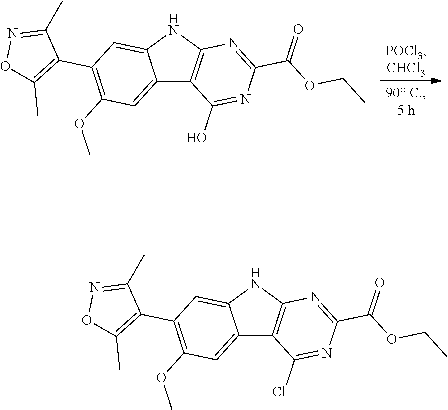 [SMILES: CCOC(=O)c1nc(O)c2c(n1)[nH]c1cc(-c3c(C)noc3C)c(OC)cc12 ; CCOC(=O)c1nc(Cl)c2c(n1)[nH]c1cc(-c3c(C)noc3C)c(OC)cc12]

A mixture of ethyl 7-(3,5-dimethylisoxazol-4-yl)-4-hydroxy-6-methoxy-9H-pyrimido[4,5-b]indole-2-carboxylate (3 g, 7.85 mmol) in POCl₃ (16.45 g, 107.28 mmol, 10 mL) and CHCl₃ (20 mL) was heated to 90° C. and stirred for 5 hours under N₂. The reaction mixture was concentrated in vacuo. The mixture was poured into water (80 mL) slowly. The mixture was extracted with ethyl acetate (50 mL×3). The combined organic phase was washed with brine (50 mL), dried with anhydrous Na₂SO₄, filtered and concentrated in vacuo. The residue was purified by column chromatography on silica gel (Petroleum ether/Ethyl acetate=2/1) to afford the desired product ethyl 4-chloro-7-(3,5-dimethylisoxazol-4-yl)-6-methoxy-9H-pyrimido[4,5-b]indole-2-carboxylate (3 g, crude) as a yellow solid. ¹H NMR: DMSO-d₆, 400 MHz. (13.05 (brs, 1H), 7.90 (s, 1H), 7.54 (s, 1H), 4.42 (q, J=7.2 Hz, 2H), 3.93 (s, 3H), 2.32 (s, 3H), 2.12 (s, 3H), 1.38 (t, J=7.2 Hz, 3H).

### F. Step 6

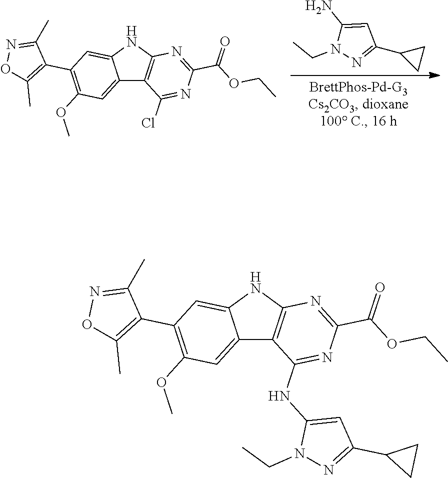 [SMILES: CCOC(=O)c1nc(Cl)c2c(n1)[nH]c1cc(-c3c(C)noc3C)c(OC)cc12 ; CCn1nc(C2CC2)cc1N ; CCOC(=O)c1nc(Nc2cc(C3CC3)nn2CC)c2c(n1)[nH]c1cc(-c3c(C)noc3C)c(OC)cc12]

A mixture of ethyl 4-chloro-7-(3,5-dimethylisoxazol-4-yl)-6-methoxy-9H-pyrimido[4,5-b]indole-2-carboxylate (500 mg, 1.25 mmol), 5-cyclopropyl-2-ethyl-pyrazol-3-amine (282.94 mg, 1.87 mmol), BrettPhos-Pd-G₃ (226.16 mg, 249.49 μmol) and Cs₂CO₃ (812.89 mg, 2.49 mmol) in dioxane (5 mL) was heated to 100° C. and stirred for 16 hours under N₂. The reaction mixture was diluted with water (10 mL). The mixture was extracted with ethyl acetate (20 mL×3). The combined organic phase was washed with brine (20 mL), dried with anhydrous Na₂SO₄, filtered and concentrated in vacuo. The residue was triturated in Petroleum ether/Ethyl acetate (1/1, 10 mL). The resultant precipitate solid was collected by filtration and dried in vacuo to afford the desired product ethyl 4-[(5-cyclopropyl-2-ethyl-pyrazol-3-yl)amino]-7-(3,5-dimethylisoxazol-4-yl)-6-methoxy-9H-pyrimido[4,5-b]indole-2-carboxylate (880 mg, crude) as a yellow solid. LCMS: RT=0.462 min, m/z 516.2 [M+H]⁺.

### G. Step 7

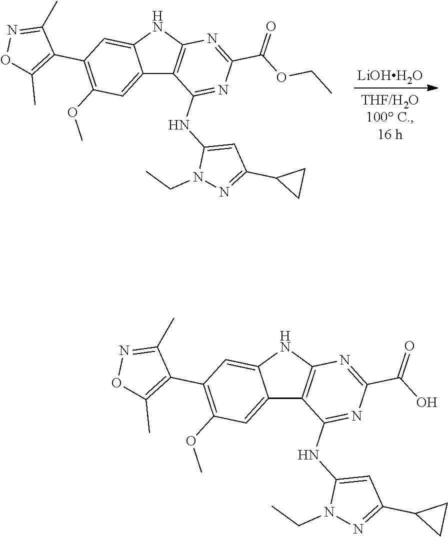 [SMILES: CCOC(=O)c1nc(Nc2cc(C3CC3)nn2CC)c2c(n1)[nH]c1cc(-c3c(C)noc3C)c(OC)cc12 ; "LiOH·H2O" ; CCn1nc(C2CC2)cc1Nc1nc(C(=O)O)nc2[nH]c3cc(-c4c(C)noc4C)c(OC)cc3c12]

To a solution of ethyl 4-[(5-cyclopropyl-2-ethyl-pyrazol-3-yl)amino]-7-(3,5-dimethylisoxazol-4-yl)-6-methoxy-9H-pyrimido[4,5-b]indole-2-carboxylate (880 mg, 1.71 mmol) in THF (5 mL) and H₂O (2 mL) was added LiOH—H₂O (214.88 mg, 5.12 mmol) at 25° C. under N₂. The mixture was stirred at 25° C. for 16 hours under N₂. The reaction mixture was diluted with water (5 mL). The pH of the mixture was adjusted to 5 by addition of 1 M aqueous HCl solution. The mixture was extracted with dichloromethane/methanol (10/1, 10 mL×3). The combined organic phase was washed with brine (10 mL), dried with anhydrous Na₂SO₄, filtered and concentrated in vacuo. The residue was purified by preparative HPLC (column: Phenomenex luna C18 150*25 mm*10 um; mobile phase: [water (FA)-ACN]; gradient: 23%-53% B over 10 min) to afford the desired product 4-[(5-cyclopropyl-2-ethyl-pyrazol-3-yl)amino]-7-(3,5-dimethylisoxazol-4-yl)-6-methoxy-9H-pyrimido[4,5-b]indole-2-carboxylic acid (25 mg, 51.28 μmol) as a yellow solid. ¹H NMR: DMSO-d₆, 400 MHz. δ 13.05 (brs, 1H), 12.25 (s, 1H), 9.28 (s, 1H), 7.50 (s, 1H), 7.34 (s, 1H), 5.89 (s, 1H), 3.95-3.91 (m, 2H), 3.82 (s, 3H), 2.33-2.31 (m, 1H), 2.30 (s, 3H), 2.09 (s, 3H), 1.33 (t, J=7.2 Hz, 3H), 0.87-0.83 (m, 2H), 0.63-0.60 (m, 2H). LCMS: RT=0.407 min, m/z 488.1 [M+H]⁺.

### H. Step 8

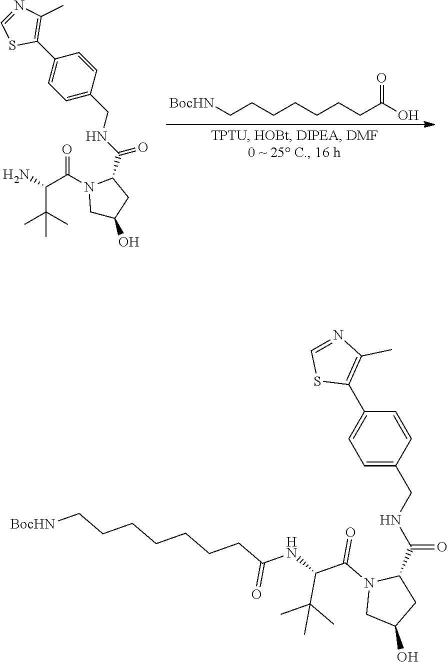 [SMILES: Cc1ncsc1-c1ccc(CNC(=O)[C@@H]2C[C@@H](O)CN2C(=O)[C@@H](N)C(C)(C)C)cc1 ; CC(C)(C)OC(=O)NCCCCCCCC(=O)O ; Cc1ncsc1-c1ccc(CNC(=O)[C@@H]2C[C@@H](O)CN2C(=O)[C@@H](NC(=O)CCCCCCCNC(=O)OC(C)(C)C)C(C)(C)C)cc1]

To a solution of (2S,4R)-1-[(2S)-2-amino-3,3-dimethyl-butanoyl]-4-hydroxy-N-[[4-(4-methylthiazol-5-yl)phenyl]methyl]pyrrolidine-2-carboxamide (200 mg, 428.24 μmol, HCl salt), 8-(tert-butoxycarbonylamino)octanoic acid (126.68 mg, 428.24 μmol) and DIPEA (332.09 mg, 2.57 mmol, 447.55 μL) in DMF (2 mL) were added TPTU (190.82 mg, 642.37 μmol) and HOBt (86.80 mg, 642.37 μmol) at 0° C. The mixture was stirred at 25° C. for 16 hours under N₂. The reaction mixture was diluted with water (2 mL). The mixture was extracted with dichloromethane/methanol (10/1, 5 mL×3). The combined organic phase was washed with brine (10 mL), dried with anhydrous Na₂SO₄, filtered and concentrated in vacuo. The residue was purified by preparative TLC on silica gel (Dichloromethane/Methanol=10/1) to afford the desired product tert-butyl N-[8-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-8-oxo-octyl]carbamate (220 mg, 314.34 μmol, 73.40% yield, 96% purity) as a yellow oil. ¹H NMR: DMSO-d₆, 400 MHz. δ 8.98 (s, 1H), 8.59-8.51 (m, 1H), 7.86-7.80 (m, 1H), 7.43-7.37 (m, 4H), 6.74 (brs, 1H), 5.13-5.10 (m, 1H), 4.56-4.52 (m, 1H), 4.47-4.39 (m, 2H), 4.37-4.33 (m, 1H), 4.25-4.18 (m, 1H), 3.69-3.59 (m, 3H), 3.19-3.12 (m, 1H), 2.44 (s, 3H), 1.36 (s, 9H), 1.26-1.21 (m, 14H), 0.93 (s, 9H). LCMS: RT=0.457 min, m/z 694.3 [M+Na]⁺.

### I. Step 9

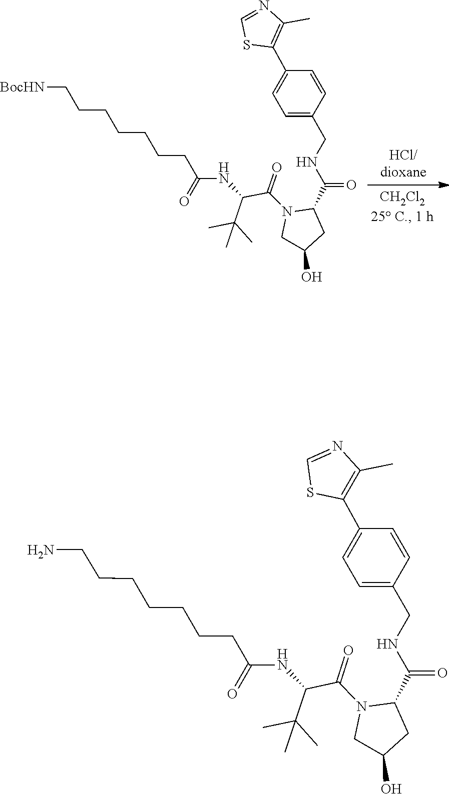 [SMILES: Cc1ncsc1-c1ccc(CNC(=O)[C@@H]2C[C@@H](O)CN2C(=O)[C@@H](NC(=O)CCCCCCCNC(=O)OC(C)(C)C)C(C)(C)C)cc1 ; Cc1ncsc1-c1ccc(CNC(=O)[C@@H]2C[C@@H](O)CN2C(=O)[C@@H](NC(=O)CCCCCCCN)C(C)(C)C)cc1]

To a solution of tert-butyl N-[8-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-8-oxo-octyl]carbamate (220 mg, 327.44 μmol) in CH₂Cl₂ (3 mL) was added HCl/dioxane (4 M in dioxnae, 12.0 mmol, 3.0 mL) at 25° C. under N₂. The reaction mixture was stirred at 25° C. for 1 hour under N₂. The reaction mixture was concentrated in vacuo to afford the desired product (2S,4R)-1-[(2S)-2-(8-aminooctanoylamino)-3,3-dimethyl-butanoyl]-4-hydroxy-N-[[4-(4-methylthiazol-5-yl)phenyl]methyl]pyrrolidine-2-carboxamide (185 mg, 298.08 μmol, 91.03% yield, 98% purity, HCl salt) as a yellow solid. LCMS: RT=0.328 min, m/z 572.4 [M+H]⁺.

### J. Step 10

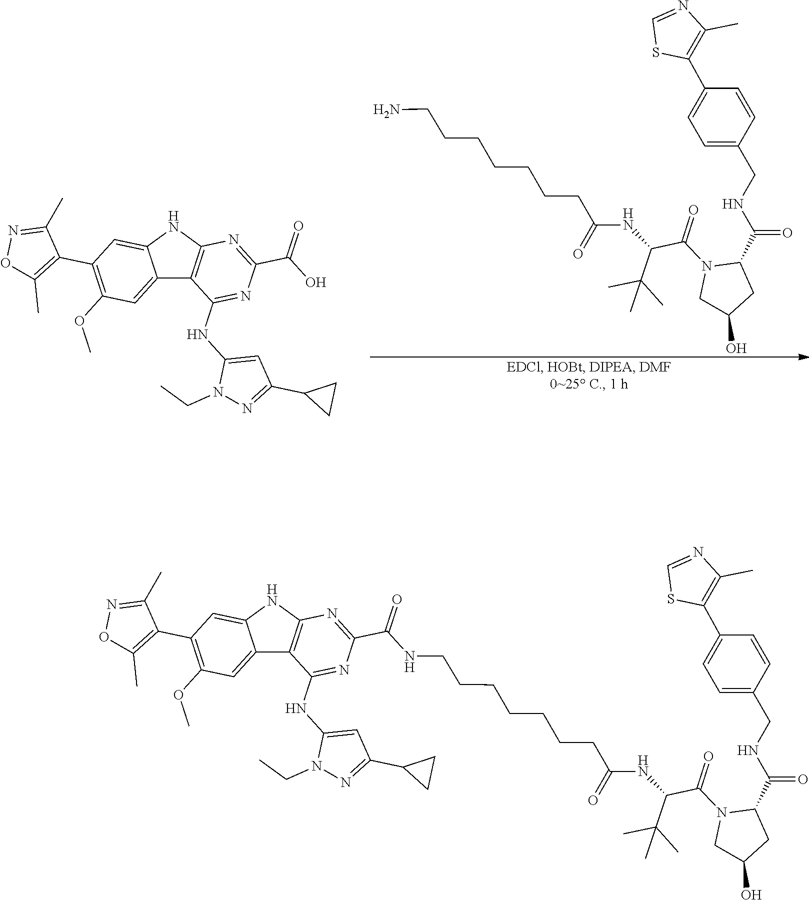 [SMILES: CCn1nc(C2CC2)cc1Nc1nc(C(=O)O)nc2[nH]c3cc(-c4c(C)noc4C)c(OC)cc3c12 ; Cc1ncsc1-c1ccc(CNC(=O)[C@@H]2C[C@@H](O)CN2C(=O)[C@@H](NC(=O)CCCCCCCN)C(C)(C)C)cc1 ; CCn1nc(C2CC2)cc1Nc1nc(C(=O)NCCCCCCCC(=O)N[C@H](C(=O)N2C[C@H](O)C[C@H]2C(=O)NCc2ccc(-c3scnc3C)cc2)C(C)(C)C)nc2[nH]c3cc(-c4c(C)noc4C)c(OC)cc3c12]

To a solution of (2S,4R)-1-[(2S)-2-(8-aminooctanoylamino)-3,3-dimethyl-butanoyl]-4-hydroxy-N-[[4-(4-methylthiazol-5-yl)phenyl]methyl]pyrrolidine-2-carboxamide (24.95 mg, 41.02 μmol, HCl salt), 4-[(5-cyclopropyl-2-ethyl-pyrazol-3-yl)amino]-7-(3,5-dimethylisoxazol-4-yl)-6-methoxy-9H-pyrimido[4,5-b]indole-2-carboxylic acid (20 mg, 41.02 μmol) and DIPEA (31.81 mg, 246.15 μmol, 42.87 μL) in DMF (0.5 mL) were added EDCI (11.80 mg, 61.54 μmol) and HOBt (8.32 mg, 61.54 μmol) at 0° C. The mixture was stirred at 25° C. for 1 hour under N₂. The reaction mixture was diluted with water (2 mL). The mixture was extracted with dichloromethane/methanol (10/1, 5 mL×3). The combined organic phase was washed with brine (5 mL), dried with anhydrous Na₂SO₄, filtered and concentrated in vacuo. The residue was purified by preparative HPLC (column: Phenomenex luna C18 150*25 mm*10 um; mobile phase: [water (FA)-ACN]; gradient: 36%-66% B over 10 min) to afford the desired product 4-[(5-cyclopropyl-2-ethyl-pyrazol-3-yl)amino]-7-(3,5-dimethylisoxazol-4-yl)-N-[8-[[(S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-8-oxo-octyl]-6-methoxy-9H-pyrimido[4,5-b]indole-2-carboxamide (5.42 mg, 5.19 μmol, 12.65% yield, 99.669% purity) as an off-white solid. ¹H NMR DMSO-d₆, 400 MHz. δ 12.21 (brs, 1H), 9.28 (brs, 1H), 8.97 (s, 1H), 8.57-8.53 (m, 1H), 8.18-8.13 (m, 1H), 7.86-7.82 (m, 1H), 7.60-7.52 (m, 1H), 7.41-7.37 (m, 4H), 7.34 (s, 1H), 5.94 (s, 1H), 5.12-5.11 (m, 1H), 4.55-4.53 (m, 1H), 4.45-4.40 (m, 2H), 4.36-4.32 (m, 1H), 4.24-4.18 (m, 1H), 3.97-3.93 (m, 2H), 3.82 (s, 3H), 3.67-3.63 (m, 2H), 3.25-3.23 (m, 2H), 2.43 (s, 3H), 2.29 (s, 3H), 2.27-2.23 (m, 1H), 2.15-2.12 (m, 1H), 2.09 (s, 3H), 2.06-1.98 (m, 2H), 1.93-1.85 (m, 3H), 1.51-1.45 (m, 4H), 1.32-1.27 (m, 11H), 0.92 (s, 9H). LCMS: m/z 1041.7 [M+H]⁺.

### Example C-2. Synthesis of (2S,4R)-1-[(2S)-2-[11-[[4-[(2S,4R)-1-acetyl-4-(4-chloroanilino)-2-methyl-3,4-dihydro-2H-quinolin-6-yl]benzoyl]amino]undecanoylamino]-3,3-dimethyl-butanoyl]-4-hydroxy-N-[[4-(4-methylthiazol-5-yl)phenyl]methyl]pyrrolidine-2-carboxamide

### A. Step 1

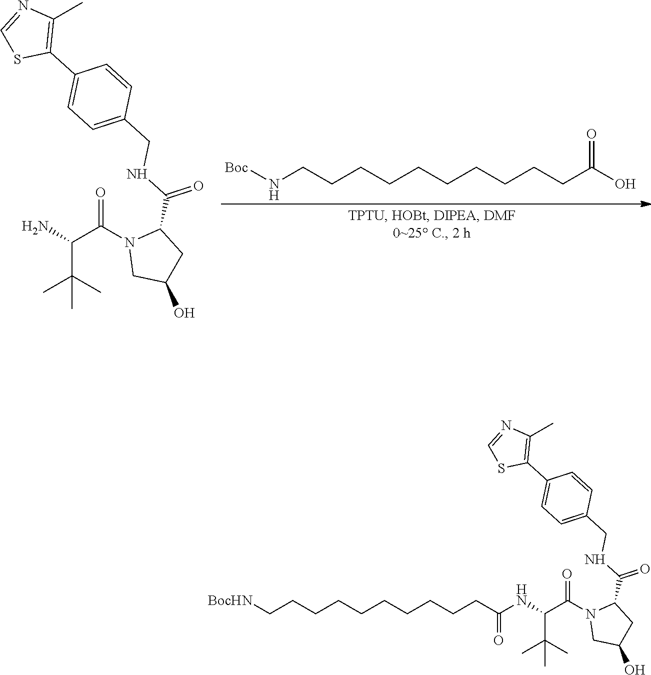 [SMILES: Cc1ncsc1-c1ccc(CNC(=O)[C@@H]2C[C@@H](O)CN2C(=O)[C@@H](N)C(C)(C)C)cc1 ; CC(C)(C)OC(=O)NCCCCCCCCCCC(=O)O ; Cc1ncsc1-c1ccc(CNC(=O)[C@@H]2C[C@@H](O)CN2C(=O)[C@@H](NC(=O)CCCCCCCCCCNC(=O)OC(C)(C)C)C(C)(C)C)cc1]

To a solution of (2S,4R)-1-[(2S)-2-amino-3,3-dimethyl-butanoyl]-4-hydroxy-N-[[4-(4-methylthiazol-5-yl)phenyl]methyl]pyrrolidine-2-carboxamide (190 mg, 406.83 μmol, HCl salt) and 11-(tert-butoxycarbonylamino)undecanoic acid (122.63 mg, 406.83 μmol) in DMF (2 mL) were added DIEA (315.48 mg, 2.44 mmol, 425.18 μL), TPTU (181.28 mg, 610.25 μmol) and HOBt (82.46 mg, 610.25 μmol) at 0° C. under N₂. The mixture was stirred at 25° C. for 2 hours under N₂. The reaction mixture was diluted with water (5 mL) and extracted with Dichloromethane/Methanol (10/1, 5 mL×3). The combined organic phase was washed with brine (5 mL), dried with anhydrous Na₂SO₄, filtered and concentrated in vacuo. The residue was purified by preparative TLC on silica gel (Dichloromethane/Methanol=10/1) to afford the desired product tert-butyl N-[11-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-11-oxo-undecyl]carbamate (210 mg, 294.13 μmol, 72.30% yield) as a yellow oil. ¹H NMR: CDCl₃, 400 MHz. δ 8.77 (s, 1H), 8.03 (brs, 1H), 7.43-7.28 (m, 6H), 6.04 (brs, 1H), 4.79-4.72 (m, 1H), 4.64-4.62 (m, 1H), 4.55-4.49 (m, 2H), 4.40-4.31 (m, 1H), 4.20-4.11 (m, 1H), 3.75-3.55 (m, 2H), 3.12-3.09 (m, 1H), 2.65-2.58 (m, 1H), 2.55 (s, 3H), 2.23-2.13 (m, 3H), 1.48-1.42 (m, 13H), 1.30-1.24 (m, 12H), 0.94 (s, 9H). LCMS: m/z 714.4 [M+H]⁺.

### B. Step 2

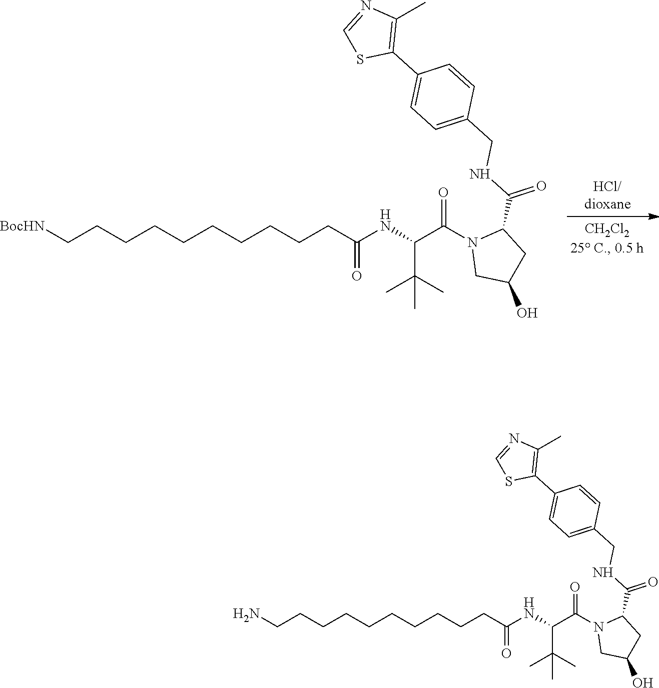 [SMILES: Cc1ncsc1-c1ccc(CNC(=O)[C@@H]2C[C@@H](O)CN2C(=O)[C@@H](NC(=O)CCCCCCCCCCNC(=O)OC(C)(C)C)C(C)(C)C)cc1 ; Cc1ncsc1-c1ccc(CNC(=O)[C@@H]2C[C@@H](O)CN2C(=O)[C@@H](NC(=O)CCCCCCCCCCN)C(C)(C)C)cc1]

To a solution of tert-butyl N-[11-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-11-oxo-undecyl]carbamate (210 mg, 294.13 μmol) in CH₂Cl₂ (2 mL) was added HCl/dioxane (4 M in dioxane, 8.0 mmol, 2.0 mL) under N₂. The mixture was stirred at 25° C. for 0.5 hour under N₂. The mixture was concentrated in vacuo to afford the desired product (2S,4R)-1-[(2S)-2-(11-aminoundecanoylamino)-3,3-dimethyl-butanoyl]-4-hydroxy-N-[[4-(4-methylthiazol-5-yl)phenyl]methyl]pyrrolidine-2-carboxamide (190 mg, 292.17 μmol, 99.33% yield, HCl salt) as a yellow solid. LCMS: m/z 614.3 [M+H]⁺.

### C. Step 3

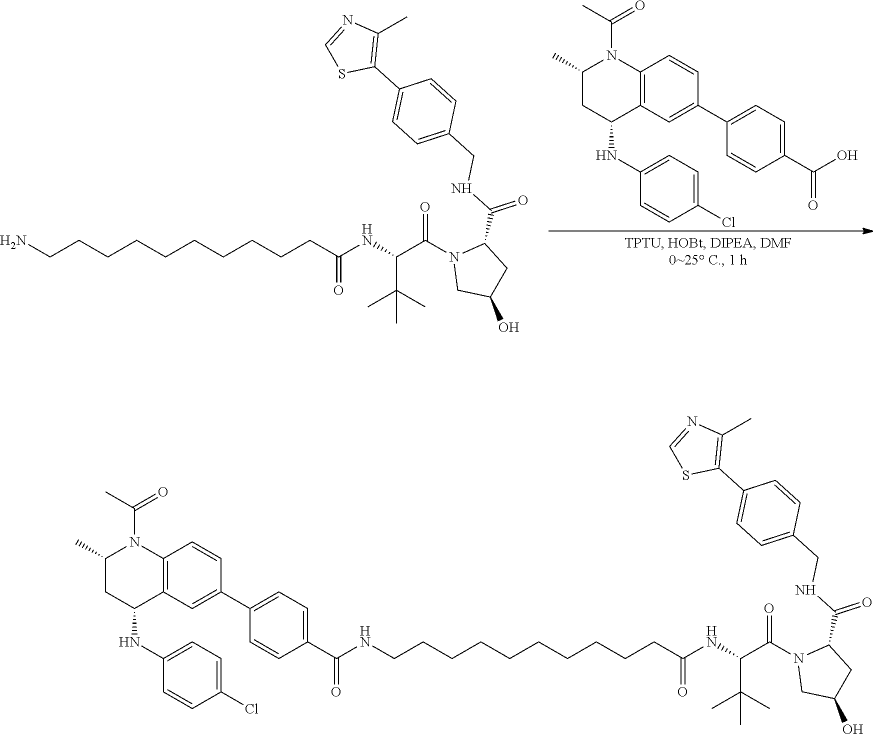 [SMILES: Cc1ncsc1-c1ccc(CNC(=O)[C@@H]2C[C@@H](O)CN2C(=O)[C@@H](NC(=O)CCCCCCCCCCN)C(C)(C)C)cc1 ; CC(=O)N1c2ccc(-c3ccc(C(=O)O)cc3)cc2[C@H](Nc2ccc(Cl)cc2)C[C@@H]1C ; CC(=O)N1c2ccc(-c3ccc(C(=O)NCCCCCCCCCCC(=O)N[C@H](C(=O)N4C[C@H](O)C[C@H]4C(=O)NCc4ccc(-c5scnc5C)cc4)C(C)(C)C)cc3)cc2[C@H](Nc2ccc(Cl)cc2)C[C@@H]1C]

To a solution of (2S,4R)-1-[(2S)-2-(11-aminoundecanoylamino)-3,3-dimethyl-butanoyl]-4-hydroxy-N-[[4-(4-methylthiazol-5-yl)phenyl]methyl]pyrrolidine-2-carboxamide (125.60 mg, 193.14 μmol, HCl salt) and 4-[(2S,4R)-1-acetyl-4-(4-chloroanilino)-2-methyl-3,4-dihydro-2H-quinolin-6-yl]benzoic acid (70 mg, 160.95 μmol) in DMF (1.5 mL) were added TPTU (71.72 mg, 241.43 μmol), HOBt (32.62 mg, 241.43 μmol) and DIEA (124.81 mg, 965.71 mol, 168.21 μL) at 0° C. under N₂. The mixture was stirred at 25° C. for 1 hour. The reaction mixture was diluted with water (5 mL) and extracted with Dichloromethane/Methanol (10/1, 5 mL×3). The combined organic phase was dried with anhydrous Na₂SO₄, filtered and concentrated in vacuo. The residue was purified by preparative HPLC (column: Daisogel SP ODS RPS 150*25 mm*5 um; mobile phase: [water (NH₄HCO₃)-ACN]; gradient: 50%-80% B over 10 min) to afford the desired product (2S,4R)-1-[(2S)-2-[11-[[4-[(2S,4R)-1-acetyl-4-(4-chloroanilino)-2-methyl-3,4-dihydro-2H-quinolin-6-yl]benzoyl]amino]undecanoylamino]-3,3-dimethyl-butanoyl]-4-hydroxy-N-[[4-(4-methylthiazol-5-yl)phenyl]methyl]pyrrolidine-2-carboxamide (62.22 mg, 60.36 μmol, 37.50% yield) as a white solid. ¹H NMR: DMSO-d₆, 400 MHz. δ 8.98 (s, 1H), 8.55 (t, J=6.0 Hz, 1H), 8.42 (t, J=5.2 Hz, 1H), 7.90-7.80 (m, 3H), 7.63-7.57 (m, 3H), 7.46-7.36 (m, 6H), 7.12 (d, J=8.8 Hz, 2H), 6.74 (d, J=8.8 Hz, 2H), 6.29 (d, J=8.4 Hz, 1H), 5.11 (d, J=3.6 Hz, 1H), 4.76-4.66 (m, 1H), 4.54 (d, J=9.2 Hz, 1H), 4.47-4.39 (m, 2H), 4.37-4.27 (m, 2H), 4.23-4.21 (m, 1H), 3.70-3.60 (m, 2H), 3.25-3.22 (m, 2H), 2.65-2.58 (m, 1H), 2.44 (s, 3H), 2.30-2.22 (m, 1H), 2.14 (s, 3H), 2.11-1.98 (m, 2H), 1.94-1.84 (m, 1H), 1.55-1.43 (m, 4H), 1.29-1.21 (m, 12H), 1.09 (d, J=6.4 Hz, 3H), 0.93 (s, 9H). LCMS: m/z 1030.8 [M+H]⁺.

### Example C-3. Synthesis of (2S,4R)-1-[(2R)-2-[3-[8-[[4-[(2S,4R)-1-acetyl-4-(4-chloroanilino)-2-methyl-3,4-dihydro-2H-quinolin-6-yl]benzoyl]amino]octoxy]isoxazol-5-yl]-3-methyl-butanoyl]-4-hydroxy-N-[[4-(4-methylthiazol-5-yl)phenyl]methyl]pyrrolidine-2-carboxamide

### A. Step 1

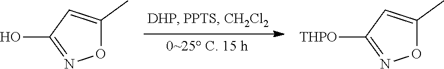

To a mixture of 5-methylisoxazol-3-ol (25 g, 252.30 mmol) and PPTS (3.17 g, 12.62 mmol) in CH₂Cl₂ (500 mL) was added DHP (25.47 g, 302.76 mmol, 27.68 mL) at 0° C. under N₂.

The mixture was warmed to 25° C. and stirred for 15 hours under N₂. The reaction mixture was diluted with water (1000 mL). The pH of the mixture was adjusted to 7-8 by addition of aqueous NaHCO₃ solution. The mixture and extracted with dichloromethane (2500 mL). The combined organic phase was washed with brine (500 mL), dried over anhydrous Na₂SO₄, filtered and concentrated in vacuo. The residue was purified by column chromatography on silica gel (dichloromethane/methanol=10/1) to afford the desired product 5-methyl-3-tetrahydropyran-2-yloxy-isoxazole (90 g, 488.31 mmol, 96.77% yield, 99.4% purity) as a light yellow solid. ¹H NMR: DMSO-d₆, 400 MHz. δ 5.47 (s, 1H), 5.34-5.30 (m, 1H), 4.07-4.01 (m, 1H), 3.70-3.57 (m, 1H), 2.25 (s, 3H), 2.15-1.96 (m, 2H), 1.88-1.79 (m, 1H), 1.71-1.50 (m, 3H). LCMS: m/z 183.9 [M+H]⁺.

### B. Step 2

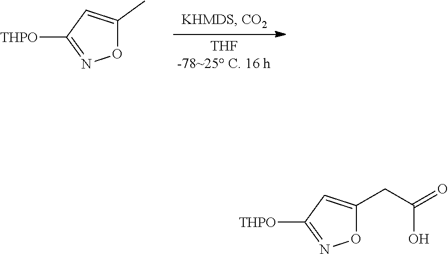

To a mixture of 5-methyl-3-tetrahydropyran-2-yloxy-isoxazole (22.5 g, 122.81 mmol) in THF (400 mL) was added dropwise KHMDS (1 M in THF, 147.38 mmol, 147.38 mL) under N₂ at −78° C. The mixture was stirred at −78° C. for 1 hour under N₂. Then the mixture was bubbled with CO₂ at −78° C. for 1 hour. The mixture was stirred at 25° C. for 14 hours under CO₂ (15 Psi). The reaction mixture was diluted with aqueous NH₄Cl solution (2500 mL). The mixture was extracted with ethyl acetate (1000 mL×2). The pH of the mixture was adjusted to 2˜3 by addition of 1 M aqueous HCl solution. Then the mixture was extracted with ethyl acetate (1000×6). The combined organic phase was dried over anhydrous Na₂SO₄, filtered and concentrated in vacuo to afford the desired product 2-(3-tetrahydropyran-2-yloxyisoxazol-5-yl)acetic acid (70 g, 308.08 mmol, 62.71% yield, four batch) as a white solid. ¹H NMR: DMSO-d₆, 400 MHz. δ 12.97 (brs, 1H), 5.78 (s, 1H), 5.24-5.20 (m, 1H), 3.90-3.86 (m, 1H), 3.74 (s, 2H), 3.59-3.48 (m, 1H), 1.98-1.84 (m, 2H), 1.81-1.72 (m, 1H), 1.69-1.57 (m, 1H), 1.51-1.38 (m, 2H). LCMS: RT=0.170 min, m/z 250.0 [M+Na]⁺.

### C. Step 3

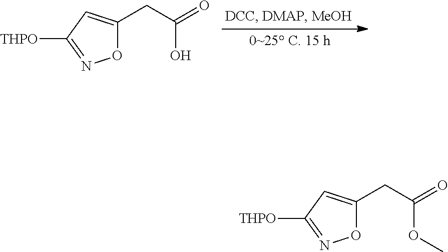

To a mixture of 2-(3-tetrahydropyran-2-yloxyisoxazol-5-yl)acetic acid (23 g, 101.23 mmol) in MeOH (500 mL) were added DCC (25.06 g, 121.47 mmol, 24.57 mL) and DMAP (12.37 g, 101.23 mmol) at 0° C. under N₂. The mixture was warmed to 25° C. and stirred for 15 hours under N₂. The mixture was concentrated in vacuo. The pH of the mixture was adjusted to 6-7 by addition of 2 M aqueous HCl solution. The mixture was extracted with ethyl acetate (1000 mL×3). The combined organic phase was washed with brine (500 mL×2), dried over anhydrous Na₂SO₄, filtered and concentrated in vacuo. The residue was purified by column chromatography on silica gel (petroleum ether/ethyl acetate=1/1) to afford the desired product methyl 2-(3-tetrahydropyran-2-yloxyisoxazol-5-yl) acetate (40 g, 165.81 mmol, 54.60% yield, three batch) as a yellow oil. ¹H NMR: DMSO-d₆, 400 MHz. δ 5.93 (s, 1H), 5.25-5.21 (m, 1H), 3.90-3.86 (m, 3H), 3.67 (s, 3H), 3.57-3.48 (m, 1H), 1.95-1.86 (m, 2H), 1.79-1.75 (m, 1H), 1.66-1.62 (m, 1H), 1.49-1.41 (m, 2H). LCMS: m/z 264.0 [M+Na]⁺.

### D. Step 4

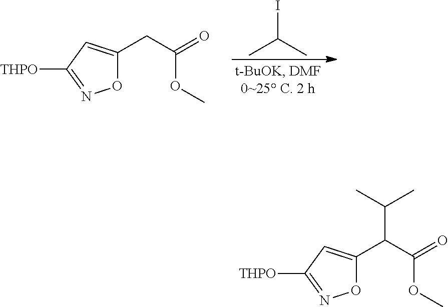

To a mixture of methyl 2-(3-tetrahydropyran-2-yloxyisoxazol-5-yl) acetate (38 g, 157.52 mmol) in DMF (300 mL) was added t-BuOK (1 M in THF, 173.27 mmol, 173.27 mL) at 0° C. under N₂. The mixture was stirred at 0° C. for 0.5 hour under N₂. Then to the mixture was added 2-iodopropane (29.45 g, 173.27 mmol, 17.30 mL) at 0° C. and stirred for 0.5 hour under N₂. The mixture was warmed to 25° C. and stirred for 1 hour under N₂. The reaction mixture was diluted with water (500 mL). The mixture was extracted with ethyl acetate (1000 mL×2). The combined organic phase was washed with brine (500 mL×2), dried with anhydrous Na₂SO₄, filtered and concentrated in vacuo. The residue was purified by column chromatography on silica gel (petroleum ether/ethyl acetate=1/1) to afford the desired product methyl 3-methyl-2-(3-tetrahydropyran-2-yloxyisoxazol-5-yl) butanoate (32 g, 112.95 mmol, 71.70% yield) as a yellow oil. ¹H NMR: DMSO-d₆, 400 MHz. δ 5.87-5.83 (m, 1H), 5.25-5.21 (m, 1H), 3.92-3.83 (m, 1H), 3.69 (s, 3H), 3.63-3.59 (m, 1H), 3.56-3.49 (m, 1H), 2.34-2.25 (m, 1H), 1.92-1.86 (m, 2H), 1.79-1.74 (m, 1H), 1.66-1.58 (m, 1H), 1.47-1.41 (m, 2H), 0.94 (d, J=6.8 Hz, 3H), 0.90 (d, J=6.8 Hz, 3H).

### E. Step 5

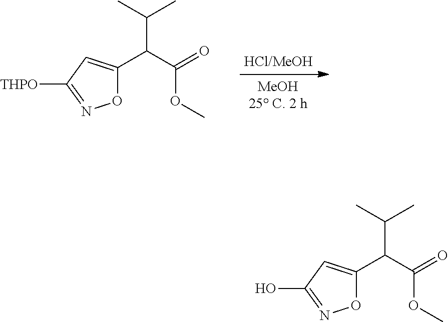

To a mixture of methyl 3-methyl-2-(3-tetrahydropyran-2-yloxyisoxazol-5-yl)butanoate (30 g, 105.89 mmol) in MeOH (300 mL) was added HCl/MeOH (4 M in the MeOH, 217.07 mmol, 54.27 mL) at 25° C. under N₂. The mixture was stirred at 25° C. for 2 hours under N₂. The mixture was concentrated in vacuo. The residue was purified by column chromatography on silica gel (petroleum ether/ethyl acetate=2/1) to afford the desired product methyl 2-(3-hydroxyisoxazol-5-yl)-3-methyl-butanoate (18 g, 90.36 mmol, 85.34% yield) as a yellow oil. ¹H NMR: 400 MHz. δ 11.22 (s, 1H), 5.94 (s, 1H), 3.65 (s, 3H), 3.62-3.60 (m, 1H), 2.32-2.22 (m, 1H), 0.92 (d, J=6.8 Hz, 3H), 0.84 (d, J=6.8 Hz, 3H). LCMS: m/z 199.9 [M+H]⁺.

### F. Step 6

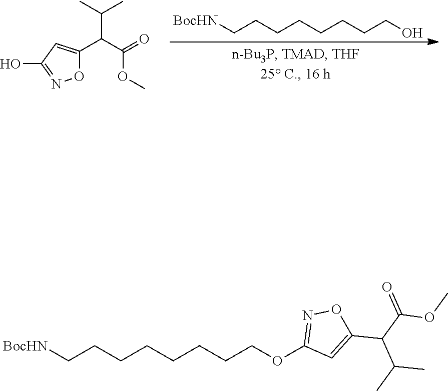 [SMILES: COC(=O)C(c1cc(O)no1)C(C)C ; CC(C)(C)OC(=O)NCCCCCCCCO ; COC(=O)C(c1cc(OCCCCCCCCNC(=O)OC(C)(C)C)no1)C(C)C]

To a mixture of methyl 2-(3-hydroxyisoxazol-5-yl)-3-methyl-butanoate (3 g, 15.06 mmol), tert-butyl N-(8-hydroxyoctyl)carbamate (4.80 g, 19.58 mmol) in THF (40 mL) were added tributylphosphane (9.14 g, 45.18 mmol, 11.15 mL) and TMAD (6.48 g, 37.65 mmol) at 25° C. under N₂. The mixture was stirred at 25° C. for 15 hours under N₂. The reaction mixture was diluted with water (200 mL). The mixture was extracted with ethyl acetate (200 mL×2). The combined organic phase was washed with brine (100 mL), dried with anhydrous Na₂SO₄, filtered and concentrated in vacuo. The residue was purified by column chromatography on silica gel (petroleum ether/ethyl acetate=5/1) to afford the desired product methyl 2-[3-[8-(tert-butoxycarbonylamino)octoxy]isoxazol-5-yl]-3-methyl-butanoate (5.4 g, crude) as a yellow oil. ¹H NMR: DMSO-d₆, 400 MHz. δ 6.78-6.72 (m 1H), 6.18 (s, 1H), 4.13 (t, J=6.4 Hz, 2H), 3.66-3.64 (m, 4H), 2.89-2.86 (m, 2H), 2.32-2.23 (m, 1H), 1.73-1.65 (m, 2H), 1.37-1.35 (m, 15H), 1.24-1.20 (m, 4H), 0.92 (d, J=6.8 Hz, 3H), 0.84 (d, J=6.8 Hz, 3H). LCMS: m/z 449.2 [M+Na]⁺.

### G. Step 7

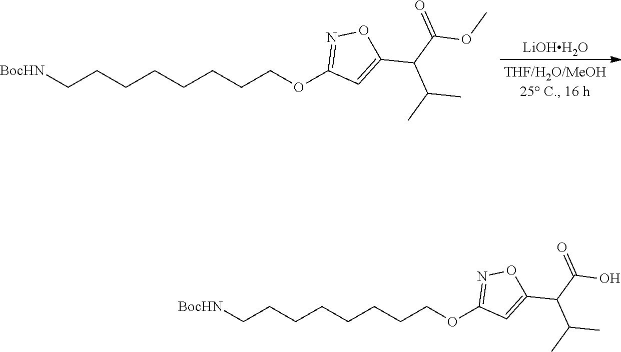 [SMILES: COC(=O)C(c1cc(OCCCCCCCCNC(=O)OC(C)(C)C)no1)C(C)C ; "LiOH·H2O" ; CC(C)C(C(=O)O)c1cc(OCCCCCCCCNC(=O)OC(C)(C)C)no1]

To a mixture of methyl 2-[3-[8-(tert-butoxycarbonylamino)octoxy]isoxazol-5-yl]-3-methyl-butanoate (2 g, 4.69 mmol) in THE (10 mL), MeOH (10 mL) and H₂O (2 mL) was added LiOH·H₂O (590.28 mg, 14.07 mmol) at 25° C. under N₂. The mixture was stirred at 25° C. for 16 hours under N₂. The residue was purified by preparative HPLC (column: Daisogel C18 250*70 mm*10 um; Smobile phase: [water (NH₄HCO₃)-ACN]; gradient: 10%-40% B over 25 min) to afford the desired product 2-[3-[8-(tert-butoxycarbonylamino)octoxy]isoxazol-5-yl]-3-methyl-butanoic acid (1.5 g, 3.64 mmol, 77.55% yield, 100% purity) as a white solid. ¹H NMR: DMSO-d₆, 400 MHz. δ 6.74 (brs, 1H), 5.98 (s, 1H), 4.11 (t, J=6.4 Hz, 2H), 3.27 (d, J=9.2 Hz, 2H), 2.90-2.88 (m, 3H), 2.26-2.15 (m, 1H), 1.76-1.63 (m, 2H), 1.39-1.32 (m, 15H), 1.25-1.21 (m, 4H), 0.93 (d, J=6.8 Hz, 3H), 0.79 (d, J=6.8 Hz, 3H). LCMS: m/z 435.3 [M+Na]⁺.

### H. Step 8

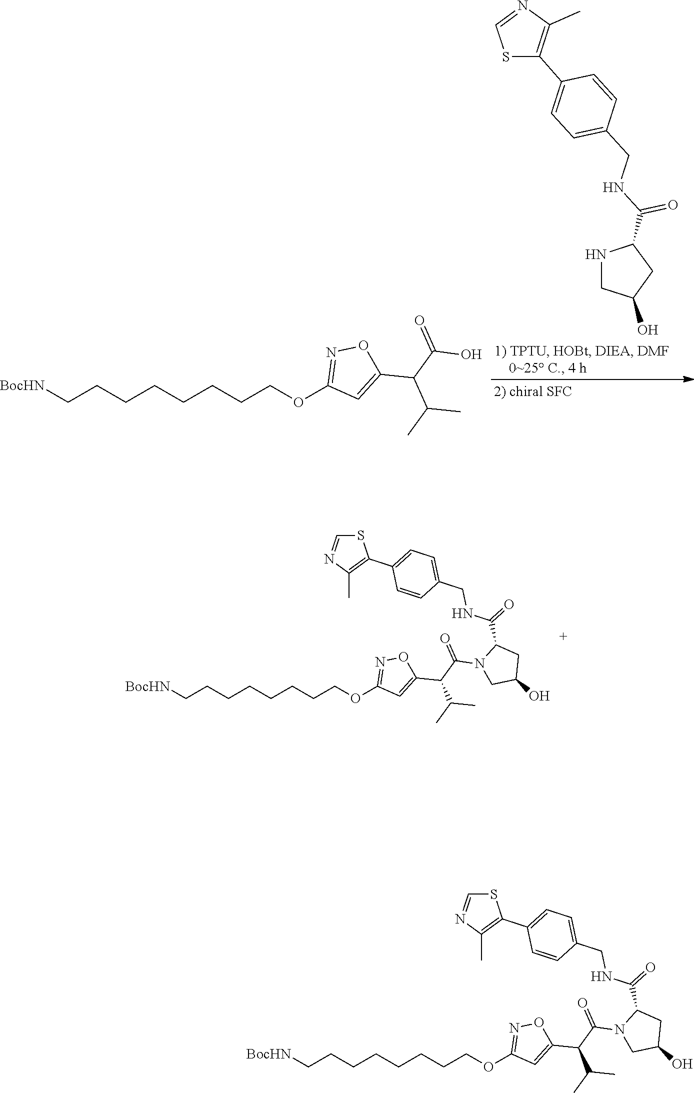

To a mixture of 2-[3-[8-(tert-butoxycarbonylamino)octoxy]isoxazol-5-yl]-3-methyl-butanoic acid (1.22 g, 2.97 mmol), (2S,4R)-4-hydroxy-N-[[4-(4-methylthiazol-5-yl)phenyl]methyl]pyrrolidine-2-carboxamide (700 mg, 1.98 mmol, HCl salt) in DMF (1 mL) were added DIEA (1.53 g, 11.87 mmol, 2.07 mL), HOBt (534.58 mg, 3.96 mmol) and TPTU (1.18 g, 3.96 mmol) at 0° C. under N₂. The mixture was warmed to 25° C. and stirred for 4 hours under N₂. The reaction mixture was diluted with water (20 mL). The mixture was extracted with dichloromethane/methanol (10/1, 50 mL×3). The combined organic phase was washed with brine (30 mL), dried with anhydrous Na₂SO₄, filtered and concentrated in vacuo. The residue was purified by preparative HPLC (column: Phenomenex luna C18 (250*70 mm*15 um); mobile phase: [water (NH₄HCO₃)-ACN]; gradient: 40%-70% B over 22 min) to afford the mixture product (LCMS-mix, SFC-mix). The mixture product was separated by chiral SFC (column: DAICEL CHIRALCEL OJ (250 mm*30 mm*10 um); mobile phase: [CO₂-MeOH (0.1% NH₃·H₂O)]; B %: 25%, isocratic elution mode) to afford the desired product tert-butyl N-[8-[5-[(1R)-1-[(2S,4R)-4-hydroxy-2-[[4-(4-methylthiazol-5-yl)phenyl]methylcarbamoyl]pyrrolidine-1-carbonyl]-2-methyl-propyl]isoxazol-3-yl]oxyoctyl]carbamate (620 mg, 870.90 μmol, 44.03% yield, 100% purity) as a yellow oil and the desired product tert-butyl N-[8-[5-[(1S)-1-[(2S,4R)-4-hydroxy-2-[[4-(4-methylthiazol-5-yl)phenyl]methylcarbamoyl]pyrrolidine-1-carbonyl]-2-methyl-propyl]isoxazol-3-yl]oxyoctyl]carbamate (600 mg, 842.80 μmol, 42.61% yield, 100% purity). ¹H NMR: DMSO-d₆, 400 MHz. δ 8.98 (s, 1H), 8.45 (t, J=5.6 Hz, 1H), 7.48-7.38 (m, 3H), 7.33-7.30 (m, 1H), 6.75-6.70 (m, 1H), 6.04 (s, 1H), 5.12 (d, J=3.2 Hz, 1H), 4.48-4.22 (m, 6H), 3.77-3.74 (m, 1H), 3.57-3.55 (m, 1H), 3.46-3.39 (m, 1H), 2.90-2.85 (m, 2H), 2.45 (s, 3H), 2.27-2.20 (m, 1H), 2.09-2.00 (m, 1H), 1.94-1.86 (m, 1H), 1.68-1.58 (m, 2H), 1.37-1.34 (m, 13H), 1.27-1.21 (m, 6H), 0.96 (d, J=6.8 Hz, 3H), 0.83 (d, J=6.8 Hz, 3H). LCMS: RT=0.500 min, m/z 712.4 [M+H]⁺. ¹H NMR: DMSO-d₆, 400 MHz. δ 8.98 (s, 1H), 8.51 (t, J=6.0 Hz, 1H), 7.46-7.41 (m, 2H), 7.40-7.35 (m, 2H), 6.75-6.72 (m, 1H), 6.07 (s, 1H), 5.10 (d, J=3.6 Hz, 1H), 4.38-4.30 (m, 4H), 4.13-4.10 (m, 1H), 3.77-3.75 (m, 1H), 3.67-3.64 (m, 1H), 3.47-3.40 (m, 2H), 2.93-2.86 (m, 2H), 2.45 (s, 3H), 2.30-2.21 (m, 1H), 2.10-1.99 (m, 1H), 1.95-1.87 (m, 1H), 1.72-1.63 (m, 2H), 1.37-1.34 (m, 13H), 1.29-1.21 (m, 6H), 0.94 (d, J=6.8 Hz, 3H), 0.80 (d, J=6.8 Hz, 3H). LCMS: RT=0.499 min, m/z 712.4 [M+H]⁺.

### I. Step 9

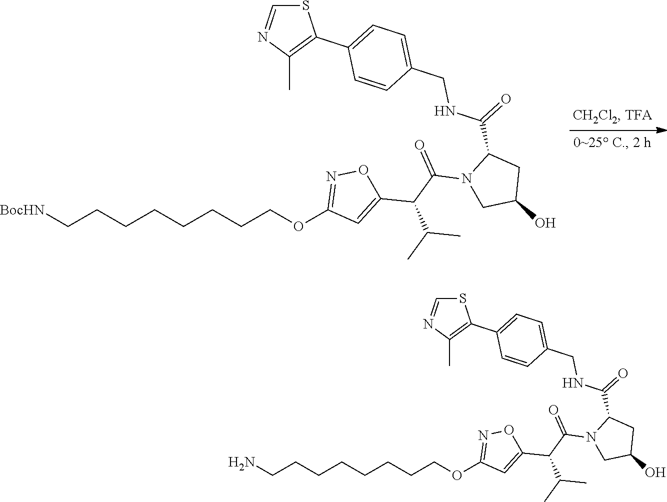 [SMILES: Cc1ncsc1-c1ccc(CNC(=O)[C@@H]2C[C@@H](O)CN2C(=O)[C@@H](c2cc(OCCCCCCCCNC(=O)OC(C)(C)C)no2)C(C)C)cc1 ; Cc1ncsc1-c1ccc(CNC(=O)[C@@H]2C[C@@H](O)CN2C(=O)[C@@H](c2cc(OCCCCCCCCN)no2)C(C)C)cc1]

To a mixture of tert-butyl N-[8-[5-[(1R)-1-[(2S,4R)-4-hydroxy-2-[[4-(4-methylthiazol-5-yl)phenyl]methylcarbamoyl]pyrrolidine-1-carbonyl]-2-methyl-propyl]isoxazol-3-yl]oxyoctyl]carbamate (600 mg, 842.80 μmol) in CH₂Cl₂ (4 mL) was added TFA (2 mL) at 0° C. under N₂. The mixture was warmed to 25° C. and stirred for 2 hours under N₂. The reaction mixture was concentrated in vacuo to afford the desired product (2S,4R)-1-[(2R)-2-[3-(8-aminooctoxy)isoxazol-5-yl]-3-methyl-butanoyl]-4-hydroxy-N-[[4-(4-methylthiazol-5-yl)phenyl]methyl]pyrrolidine-2-carboxamide (550 mg, 757.77 μmol, 89.91% yield, TFA salt) as a yellow oil. LCMS: RT=0.588 min, m/z 612.6 [M+H]⁺.

### J. Step 10

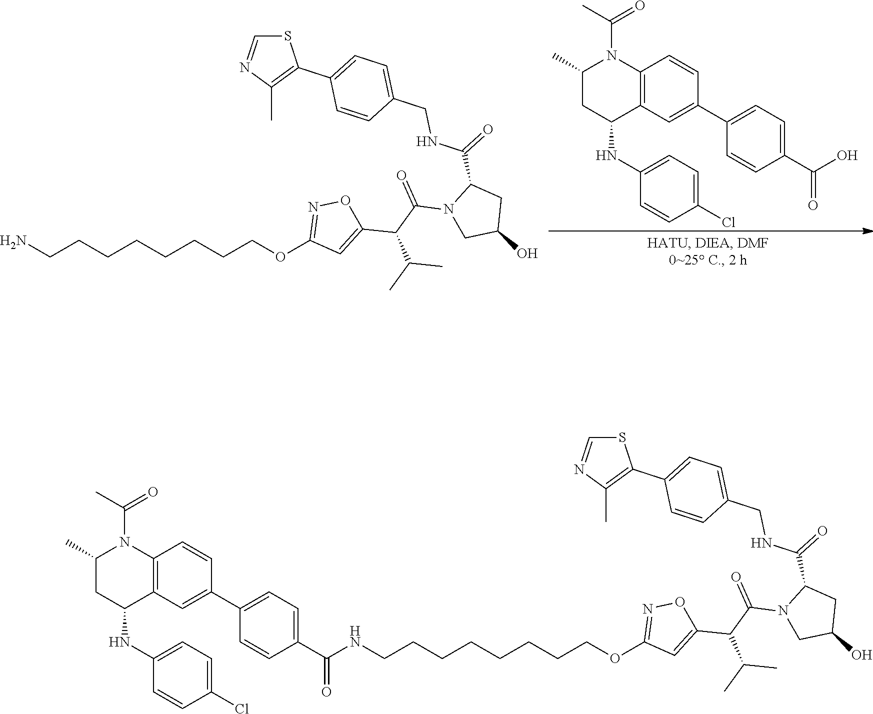

To a mixture of (2S,4R)-1-[(2R)-2-[3-(8-aminooctoxy)isoxazol-5-yl]-3-methyl-butanoyl]-4-hydroxy-N-[[4-(4-methylthiazol-5-yl)phenyl]methyl]pyrrolidine-2-carboxamide (200 mg, 275.55 μmol, TFA salt), 4-[(2S,4R)-1-acetyl-4-(4-chloroanilino)-2-methyl-3,4-dihydro-2H-quinolin-6-yl]benzoic acid (119.84 mg, 275.55 μmol) in DMF (1 mL) were added DIEA (213.68 mg, 1.65 mmol, 287.98 μL) and HATU (209.55 mg, 551.10 μmol) at 0° C. under N₂. The mixture was warmed to 25° C. and stirred for 2 hours under N₂. The reaction mixture was diluted with water (10 mL). The mixture was extracted with ethyl acetate (10 mL×2). The combined organic phase was washed with brine (10 mL), dried with anhydrous Na₂SO₄, filtered and concentrated in vacuo. The residue was purified by preparative HPLC (column: Waters Xbridge BEH C18 250*50 mm*10 um; mobile phase: [water (NH₄HCO₃)-ACN]; gradient: 47%-77% B over 10 min) to afford the desired product (2S,4R)-1-[(2R)-2-[3-[8-[[4-[(2S,4R)-1-acetyl-4-(4-chloroanilino)-2-methyl-3,4-dihydro-2H-quinolin-6-yl]benzoyl]amino]octoxy]isoxazol-5-yl]-3-methyl-butanoyl]-4-hydroxy-N-[[4-(4-methylthiazol-5-yl)phenyl]methyl]pyrrolidine-2-carboxamide (71.78 mg, 68.17 μmol, 24.74% yield, 97.7% purity) as a white solid. ¹H NMR: DMSO-d₆, 400 MHz. δ 8.98 (s, 1H), 8.52 (t, J=6.0 Hz, 1H), 8.43 (t, J=5.6 Hz, 1H), 7.90-7.88 (m, 2H), 7.61-7.57 (m, 3H), 7.45-7.40 (m, 4H), 7.39-7.35 (m, 2H), 7.12 (d, J=8.8 Hz, 2H), 6.74 (d, J=8.8 Hz, 2H), 6.29 (d, J=8.0 Hz, 1H), 6.07 (s, 1H), 5.11 (d, J=3.6 Hz, 1H), 4.74-4.67 (m, 1H), 4.38-4.27 (m, 5H), 4.12 (t, J=6.4 Hz, 2H), 3.80-3.73 (m, 1H), 3.67-3.64 (m, 1H), 3.46-3.42 (m, 1H), 3.27-3.21 (m, 2H), 2.65-2.60 (m, 1H), 2.45 (s, 3H), 2.29-2.20 (m, 1H), 2.14 (s, 3H), 2.08-2.00 (m, 1H), 1.96-1.85 (m, 1H), 1.73-1.63 (m, 2H), 1.54-1.48 (m, 2H), 1.37-1.24 (m, 9H), 1.09 (d, J=6.0 Hz, 3H), 0.94 (d, J=6.4 Hz, 3H), 0.81-0.76 (m, 3H). LCMS: RT=2.766 min, m/z 1028.7 [M+H]⁺.

### Example C-4. Synthesis of (2S,4R)-1-[(2S)-2-[3-[8-[[4-[(2S,4R)-1-acetyl-4-(4-chloroanilino)-2-methyl-3,4-dihydro-2H-quinolin-6-yl]benzoyl]amino]octoxy]isoxazol-5-yl]-3-methyl-butanoyl]-4-hydroxy-N-[[4-(4-methylthiazol-5-yl)phenyl]methyl]pyrrolidine-2-carboxamide

### A. Step 1

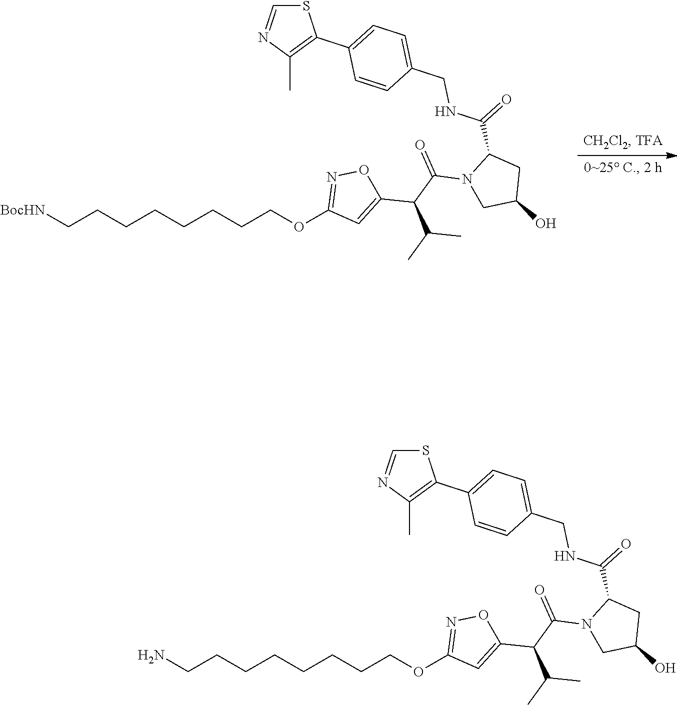 [SMILES: Cc1ncsc1-c1ccc(CNC(=O)[C@@H]2C[C@@H](O)CN2C(=O)[C@H](c2cc(OCCCCCCCCNC(=O)OC(C)(C)C)no2)C(C)C)cc1 ; Cc1ncsc1-c1ccc(CNC(=O)[C@@H]2C[C@@H](O)CN2C(=O)[C@H](c2cc(OCCCCCCCCN)no2)C(C)C)cc1]

To a mixture of tert-butyl N-[8-[5-[(1S)-1-[(2S,4R)-4-hydroxy-2-[[4-(4-methylthiazol-5-yl)phenyl]methylcarbamoyl]pyrrolidine-1-carbonyl]-2-methyl-propyl]isoxazol-3-yl]oxyoctyl]carbamate (600 mg, 842.80 μmol) in CH₂Cl₂ (4 mL) was added TFA (2 mL) at 0° C. under N₂. The mixture was warmed to 25° C. and stirred for 2 hours under N₂. The reaction mixture was concentrated in vacuo to afford the desired product (2S,4R)-1-[(2S)-2-[3-(8-aminooctoxy)isoxazol-5-yl]-3-methyl-butanoyl]-4-hydroxy-N-[[4-(4-methylthiazol-5-yl)phenyl]methyl]pyrrolidine-2-carboxamide (520 mg, 716.43 μmol, 85.01% yield, TFA salt) as a yellow oil. LCMS: m/z 612.3 [M+H]⁺.

### B. Step 2

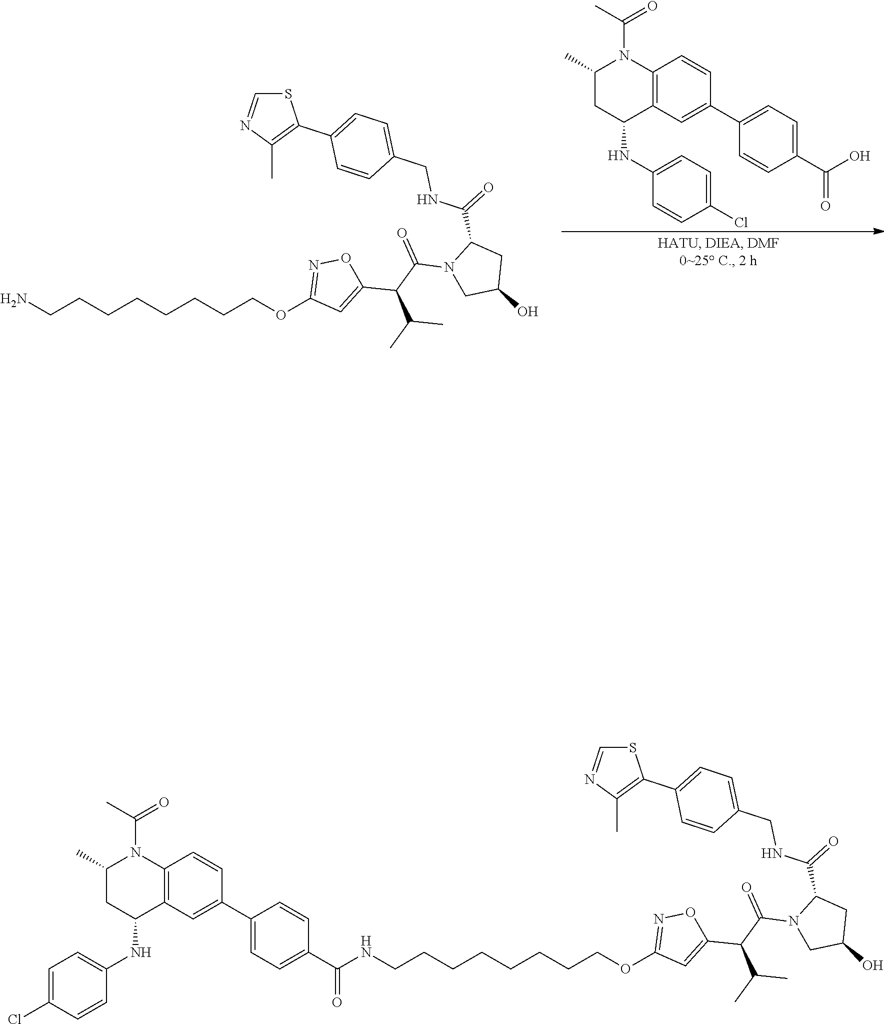 [SMILES: Cc1ncsc1-c1ccc(CNC(=O)[C@@H]2C[C@@H](O)CN2C(=O)[C@H](c2cc(OCCCCCCCCN)no2)C(C)C)cc1 ; CC(=O)N1c2ccc(-c3ccc(C(=O)O)cc3)cc2[C@H](Nc2ccc(Cl)cc2)C[C@@H]1C ; CC(=O)N1c2ccc(-c3ccc(C(=O)NCCCCCCCCOc4cc([C@@H](C(=O)N5C[C@H](O)C[C@H]5C(=O)NCc5ccc(-c6scnc6C)cc5)C(C)C)on4)cc3)cc2[C@H](Nc2ccc(Cl)cc2)C[C@@H]1C]

To a mixture of (2S,4R)-1-[(2S)-2-[3-(8-aminooctoxy)isoxazol-5-yl]-3-methyl-butanoyl]-4-hydroxy-N-[[4-(4-methylthiazol-5-yl)phenyl]methyl]pyrrolidine-2-carboxamide (200 mg, 275.55 μmol, TFA salt), 4-[(2S,4R)-1-acetyl-4-(4-chloroanilino)-2-methyl-3,4-dihydro-2H-quinolin-6-yl]benzoic acid (119.84 mg, 275.55 μmol) in DMF (1 mL) were added DIEA (213.67 mg, 1.65 mmol, 287.97 μL) and HATU (209.55 mg, 551.10 μmol) at 0° C. under N₂. The mixture was warmed to 25° C. and stirred for 2 hours under N₂. The reaction mixture was diluted with water (10 mL). The mixture was extracted with ethyl acetate (10 mL×2). The combined organic phase was washed with brine (10 mL), dried with anhydrous Na₂SO₄, filtered and concentrated in vacuo. The residue was purified by preparative HPLC ((column: Waters Xbridge BEH C18 250*50 mm*10 um; mobile phase: [water (NH₄HCO₃)-ACN]; gradient: 47%-77% B over 10 min) to afford the desired product (2S,4R)-1-[(2S)-2-[3-[8-[[4-[(2S,4R)-1-acetyl-4-(4-chloroanilino)-2-methyl-3,4-dihydro-2H-quinolin-6-yl]benzoyl]amino]octoxy]isoxazol-5-yl]-3-methyl-butanoyl]-4-hydroxy-N-[[4-(4-methylthiazol-5-yl)phenyl]methyl]pyrrolidine-2-carboxamide (71.78 mg, 68.17 μmol, 24.74% yield, 97.7% purity) as a white solid. ¹H NMR: DMSO-d₆, 400 MHz. δ 8.98 (s, 1H), 8.52 (t, J=6.0 Hz, 1H), 8.43 (t, J=5.6 Hz, 1H), 7.89-7.87 (m, 2H), 7.61-7.57 (m, 3H), 7.47-7.40 (m, 4H), 7.39-7.35 (m, 2H), 7.12 (d, J=8.8 Hz, 2H), 6.74 (d, J=8.8 Hz, 2H), 6.29 (d, J=8.0 Hz, 1H), 6.07 (s, 1H), 5.11 (d, J=3.6 Hz, 1H), 4.77-4.66 (m, 1H), 4.40-4.23 (m, 5H), 4.12 (t, J=6.4 Hz, 2H), 3.80-3.73 (m, 1H), 3.67-3.65 (m, 1H), 3.45-3.43 (m, 1H), 3.27-3.21 (m, 2H), 2.65-2.57 (m, 1H), 2.45 (s, 3H), 2.28-2.20 (m, 1H), 2.14 (s, 3H), 2.07-1.99 (m, 1H), 1.95-1.85 (m, 1H), 1.74-1.63 (m, 2H), 1.54-1.48 (m, 2H), 1.36-1.21 (m, 9H), 1.09 (d, J=6.4 Hz, 3H), 0.94 (d, J=6.4 Hz, 3H), 0.84-0.76 (m, 3H). LCMS: m/z 1028.6 [M+H]⁺

### Example C-5. Synthesis of (2S,4R)-1-[(2S)-2-[[2-[9-[2-[[4-[(2S,4R)-1-acetyl-4-(4-chloroanilino)-2-methyl-3,4-dihydro-2H-quinolin-6-yl]benzoyl]amino]ethyl]-3,9-diazaspiro[5.5]undecan-3-yl]acetyl]amino]-3,3-dimethyl-butanoyl]-4-hydroxy-n-[[4-(4-methylthiazol-5-yl)phenyl]methyl]pyrrolidine-2-carboxamide

### A. Step 1

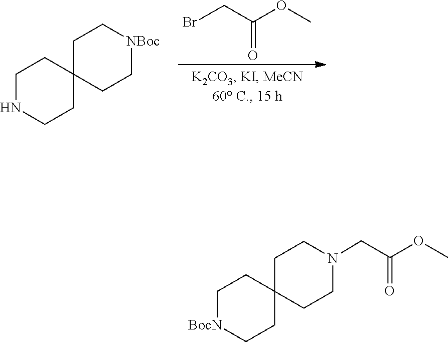

To a mixture of tert-butyl 3,9-diazaspiro[5.5]undecane-3-carboxylate (2 g, 7.86 mmol), methyl 2-bromoacetate (1.80 g, 11.79 mmol, 1.12 mL), K₂CO₃ (3.26 g, 23.59 mmol) and KI (1.31 g, 7.86 mmol) in MeCN (20 mL) was stirred at 60° C. under N₂ for 15 hours. The reaction mixture was diluted with water (20 mL) and extracted with ethyl acetate (25 mL×3). The combined organic phase was washed with brine (20 mL), dried with anhydrous Na₂SO₄, filtered and concentrated in vacuo. The residue was purified by column chromatography on silica gel (Dichloromethane/Methanol=20/1) to afford the desired product tert-butyl 9-(2-methoxy-2-oxo-ethyl)-3, 9-diazaspiro [5.5]undecane-3-carboxylate (650 mg, 1.99 mmol, 25.33% yield) as a yellow oil. ¹H NMR: CDCl₃, 400 MHz. δ 3.73 (s, 3H), 3.39-3.35 (m, 4H), 3.26 (s, 2H), 2.56 (s, 4H), 1.61-1.57 (m, 4H), 1.47-1.44 (m, 13H).

### B. Step 2

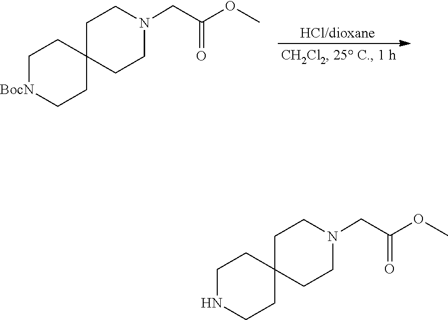 [SMILES: COC(=O)CN1CCC2(CC1)CCN(C(=O)OC(C)(C)C)CC2 ; COC(=O)CN1CCC2(CCNCC2)CC1]

To a solution of tert-butyl 9-(2-methoxy-2-oxo-ethyl)-3, 9-diazaspiro [5.5]undecane-3-carboxylate (650 mg, 1.99 mmol) in CH₂Cl₂ (6 mL) was added HCl/dioxane (4 M in dioxane, 24.0 mmol, 6 mL). The mixture was stirred at 25° C. under N₂ for 1 hour. The reaction mixture was concentrated in vacuo to afford the desired product methyl 2-(3,9-diazaspiro[5.5]undecan-3-yl)acetate (590 mg, 1.95 mmol, 98.03% yield, 99% purity, 2HCl salt) as a white solid. LCMS: m/z 226.9 [M+H]⁺.

### C. Step 3

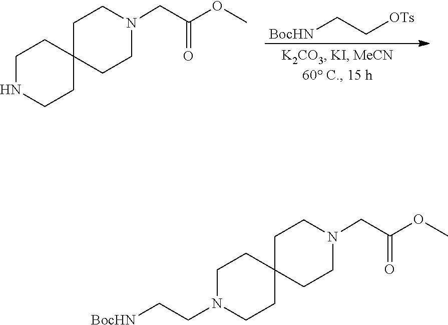 [SMILES: COC(=O)CN1CCC2(CCNCC2)CC1 ; Cc1ccc(S(=O)(=O)OCCNC(=O)OC(C)(C)C)cc1 ; COC(=O)CN1CCC2(CCN(CCNC(=O)OC(C)(C)C)CC2)CC1]

A mixture of methyl 2-(3, 9-diazaspiro [5.5]undecan-3-yl) acetate (540 mg, 1.80 mmol, 2HCl salt), 2-(tert-butoxycarbonylamino) ethyl 4-methylbenzenesulfonate (853.71 mg, 2.71 mmol), K₂CO₃ (748.24 mg, 5.41 mmol) and KI (299.56 mg, 1.80 mmol) in MeCN (10 mL) was heated to 60° C. and stirred for 15 hours under N₂. The reaction mixture was diluted with water (10 mL) and extracted with ethyl acetate (15 mL×3). The combined organic phase was washed with brine (10 mL), dried with anhydrous Na₂SO₄, filtered and concentrated in vacuo. The residue was purified by preparative HPLC (column: Phenomenex luna C18 150*25 mm*10 um; mobile phase: [water (FA)-ACN]; gradient: 1%-25% B over 8 min) to afford the desired product methyl 2-[9-[2-(tert-butoxycarbonylamino) ethyl]-3, 9-diazaspiro [5.5]undecan-3-yl]acetate (700 mg, crude) as a yellow oil. LCMS: m/z 370.0 [M+H]⁺.

### D. Step 4

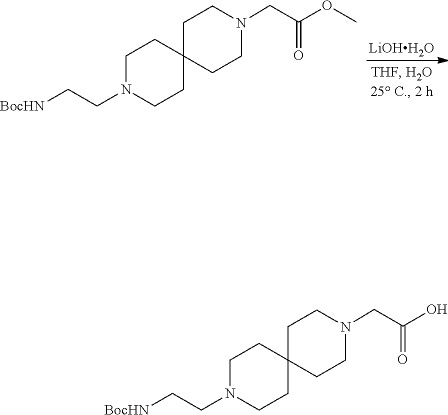

To a mixture of methyl 2-[9-[2-(tert-butoxycarbonylamino) ethyl]-3, 9-diazaspiro [5.5]undecan-3-yl]acetate (650 mg, 1.76 mmol) in THF (5 mL) and H₂O (1 mL) was added LiOH H₂O (221.46 mg, 5.28 mmol). The mixture was stirred at 25° C. under N₂ for 2 hours. The reaction mixture was concentrated in vacuo. Then the residue was adjusted to pH 7 by addition of 1 N aqueous HCl solution. The residue was purified by preparative HPLC (column: Daisogel SP ODS RPS 150*25 mm*5 um; mobile phase: [water (NH₄HCO₃)-ACN]; gradient: 5%-35% B over 10 min) to afford the desired product 2-[9-[2-(tert-butoxycarbonylamino)ethyl]-3,9-diazaspiro[5.5]undecan-3-yl]acetic acid (180 mg, 503.84 μmol, 28.64% yield, 99.5% purity) as a white solid. LCMS: m/z 356.0 [M+H]⁺.

### E. Step 5

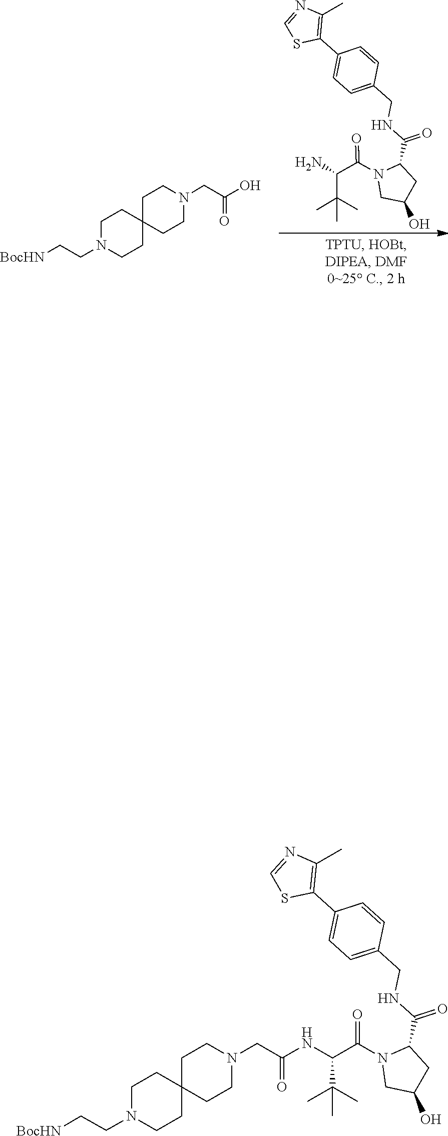 [SMILES: CC(C)(C)OC(=O)NCCN1CCC2(CC1)CCN(CC(=O)O)CC2 ; Cc1ncsc1-c1ccc(CNC(=O)[C@@H]2C[C@@H](O)CN2C(=O)[C@@H](N)C(C)(C)C)cc1 ; Cc1ncsc1-c1ccc(CNC(=O)[C@@H]2C[C@@H](O)CN2C(=O)[C@@H](NC(=O)CN2CCC3(CCN(CCNC(=O)OC(C)(C)C)CC3)CC2)C(C)(C)C)cc1]

To a mixture of 2-[9-[2-(tert-butoxycarbonylamino)ethyl]-3,9-diazaspiro[5.5]372ndecane-3-yl]acetic acid (180 mg, 506.37 μmol), (2S,4R)-1-[(2S)-2-amino-3,3-dimethyl-butanoyl]-4-hydroxy-N-[[4-(4-methylthiazol-5-yl)phenyl]methyl]pyrrolidine-2-carboxamide (236.49 mg, 506.37 μmol, HCl salt) and DIEA (261.78 mg, 2.03 mmol, 352.80 Ml) in DMF (2 mL) were added TPTU (300.84 mg, 1.01 mmol) and HOBt (136.84 mg, 1.01 mmol) at 0° C. The mixture was stirred at 25° C. under N₂ for 2 hours. The reaction mixture was diluted with water (2 mL) and extracted with ethyl acetate (3 mL×3). The combined organic phase was washed with brine (2 mL), dried with anhydrous Na₂SO₄, filtered and concentrated in vacuo. The residue was purified by preparative TLC on silica gel (Dichloromethane/Methanol=5/1). to afford the desired product tert-butyl N-[2-[3-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethyl]-3,9-diazaspiro[5.5]372ndecane-9-yl]ethyl]carbamate (380 mg, 494.78 μmol, 97.71% yield) as a yellow oil. LCMS: m/z 768.5 [M+H]⁺.

### F. Step 6

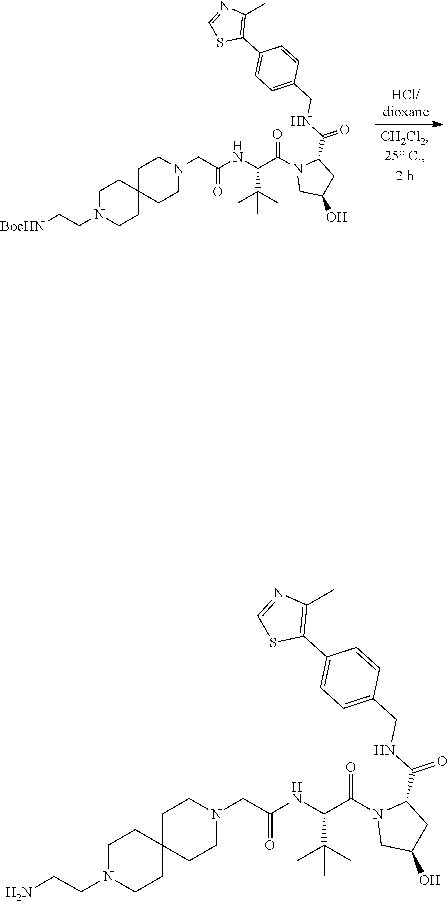 [SMILES: Cc1ncsc1-c1ccc(CNC(=O)[C@@H]2C[C@@H](O)CN2C(=O)[C@@H](NC(=O)CN2CCC3(CCN(CCNC(=O)OC(C)(C)C)CC3)CC2)C(C)(C)C)cc1 ; Cc1ncsc1-c1ccc(CNC(=O)[C@@H]2C[C@@H](O)CN2C(=O)[C@@H](NC(=O)CN2CCC3(CCN(CCN)CC3)CC2)C(C)(C)C)cc1]

To a solution of tert-butyl N-[2-[3-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethyl]-3,9-diazaspiro[5.5]undecan-9-yl]ethyl]carbamate (380 mg, 494.78 mol) in CH₂Cl₂ (4 mL) was added HCl/dioxane (4 M in dioxane, 16.00 mmol, 4 mL). The mixture was stirred at 25° C. under N₂ for 2 hours. The reaction mixture was concentrated in vacuo. The residue was purified by preparative HPLC (column: Welch Ultimate C18 150*25 mm*5 um; mobile phase: [water (TFA)-ACN]; gradient: 5%-35% B over 2 min) to afford the desired product (2S,4R)-1-[(2S)-2-[[2-[9-(2-aminoethyl)-3,9-diazaspiro[5.5]undecan-3-yl]acetyl]amino]-3,3-dimethyl-butanoyl]-4-hydroxy-N-[[4-(4-methylthiazol-5-yl)phenyl]methyl]pyrrolidine-2-carboxamide (30 mg, 42.34 μmol, 8.56% yield, 99.4% purity, HCl salt) as a colorless oil. LCMS: m/z 668.5 [M+H]⁺.

### G. Step 7

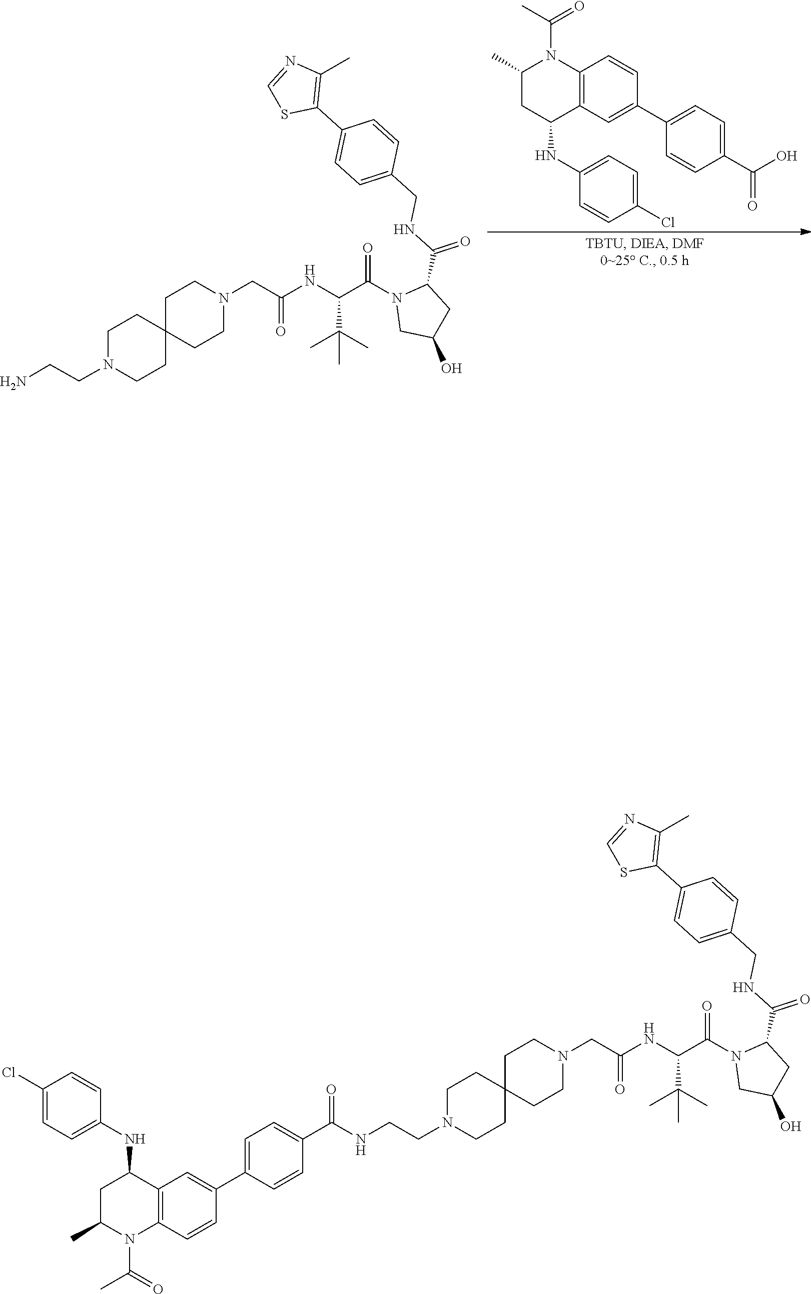 [SMILES: Cc1ncsc1-c1ccc(CNC(=O)[C@@H]2C[C@@H](O)CN2C(=O)[C@@H](NC(=O)CN2CCC3(CCN(CCN)CC3)CC2)C(C)(C)C)cc1 ; CC(=O)N1c2ccc(-c3ccc(C(=O)O)cc3)cc2[C@H](Nc2ccc(Cl)cc2)C[C@@H]1C ; CC(=O)N1c2ccc(-c3ccc(C(=O)NCCN4CCC5(CC4)CCN(CC(=O)N[C@H](C(=O)N4C[C@H](O)C[C@H]4C(=O)NCc4ccc(-c6scnc6C)cc4)C(C)(C)C)CC5)cc3)cc2[C@H](Nc2ccc(Cl)cc2)C[C@@H]1C]

To a solution of mixture of (2S,4R)-1-[(2S)-2-[[2-[9-(2-aminoethyl)-3,9-diazaspiro[5.5]undecan-3-yl]acetyl]amino]-3,3-dimethyl-butanoyl]-4-hydroxy-N-[[4-(4-methylthiazol-5-yl)phenyl]methyl]pyrrolidine-2-carboxamide (25 mg, 35.49 μmol, HCl salt) and 4-[(2S,4R)-1-acetyl-4-(4-chloroanilino)-2-methyl-3,4-dihydro-2H-quinolin-6-yl]benzoic acid (15.44 mg, 35.49 μmol) in DMF (1 mL) were added DIEA (18.35 mg, 141.97 μmol, 24.73 μL) and TBTU (22.79 mg, 70.99 μmol) at 0° C. The mixture was stirred at 25° C. under N₂ for 0.5 hour. The reaction mixture was diluted with water (1 mL) and extracted with ethyl acetate (2 mL×3). The combined organic phase was washed with brine (1 mL), dried with anhydrous Na₂SO₄, filtered and concentrated in vacuo. The residue was purified by preparative HPLC (column: Phenomenex luna C18 150*25 mm*10 um; mobile phase: [water (FA)-ACN]; gradient: 17%-47% B over 10 min) to afford the desired product (2S,4R)-1-[(2S)-2-[[2-[9-[2-[[4-[(2S,4R)-1-acetyl-4-(4-chloroanilino)-2-methyl-3,4-dihydro-2H-quinolin-6-yl]benzoyl]amino]ethyl]-3,9-diazaspiro[5.5]undecan-3-yl]acetyl]amino]-3,3-dimethyl-butanoyl]-4-hydroxy-N-[[4-(4-methylthiazol-5-yl)phenyl]methyl]pyrrolidine-2-carboxamide (11.02 mg, 10.16 μmol, 28.62% yield) as a white solid. ¹H NMR: DMSO-d₆, 400 MHz. δ 8.99 (s, 1H), 8.60 (t, J=5.6 Hz, 1H), 8.39 (t, J=5.2 Hz, 1H), 8.20 (s, 1H), 7.90-7.87 (m, 2H), 7.80 (d, J=10.0 Hz, 1H), 7.63-7.60 (m, 3H), 7.47-7.37 (m, 6H), 7.14-7.12 (m, 2H), 6.74 (d, J=8.8 Hz, 2H), 6.29 (d, J=8.0 Hz, 1H), 5.20-5.08 (m, 1H), 4.78-4.67 (m, 1H), 4.51-4.22 (m, 7H), 3.65-3.59 (m, 2H), 2.99-2.89 (m, 2H), 2.64-2.59 (m, 1H), 2.47-2.37 (m, 13H), 2.14 (s, 3H), 2.08-1.89 (m, 2H), 1.48-1.37 (m, 8H), 1.26-1.22 (m, 1H), 1.09 (d, 0.1=6.4 Hz, 3H), 0.93 (s, 9H). LCMS: m/z 1084.7 [M+H]⁺.

### Example C-6. Synthesis of (2S,4R)-1-[(2S)-2-[[2-[4-[4-[[[4-[(2S,4R)-1-acetyl-4-(4-chloroanilino)-2-methyl-3,4-dihydro-2H-quinolin-6-yl]benzoyl]amino]methyl]phenyl]phenyl]acetyl]amino]-3,3-dimethyl-butanoyl]-4-hydroxy-n-[[4-(4-methylthiazol-5-yl)phenyl]methyl]pyrrolidine-2-carboxamide

### A. Step 1

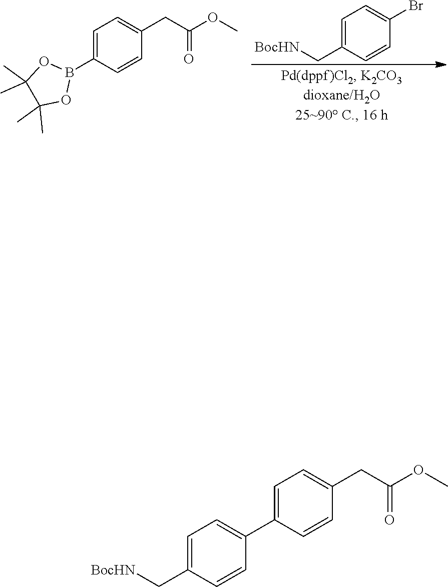

To a mixture of tert-butyl N-[(4-bromophenyl)methyl]carbamate (1.8 g, 6.29 mmol), methyl 2-[4-(4,4,5,5-tetramethyl-1,3,2-dioxaborolan-2-yl)phenyl]acetate (1.74 g, 6.29 mmol) and K₂CO₃ (1.74 g, 12.58 mmol) in dioxane (15 mL) and H₂O (1.5 mL) was added Pd(dppf)Cl₂ (920.50 mg, 1.26 mmol) at 25° C. The mixture was heated to 90° C. and stirred for 16 hours under N₂. The reaction mixture was filtered and diluted with water (15 mL), extracted with dichloromethane (15 mL×3). The combined organic layer was washed with brine (30 mL×3), dried over anhydrous Na₂SO₄, filtered and concentrated in vacuo. The residue was purified by column chromatography on silica gel (Petroleum ether/Ethyl acetate=1/3).to afford the desired product methyl 2-[4-[4-[(tert-butoxycarbonylamino) methyl]phenyl]phenyl]acetate (2.05 g, 5.50 mmol, 87.39% yield, 95.3% purity) as a yellow oil. ¹H NMR: CDCl₃, 400 MHz. δ 7.58-7.51 (m, 4H), 7.39-7.33 (m, 4H), 4.88 (brs, 1H), 4.37 (d, J=5.2 Hz, 2H), 3.73 (s, 3H), 3.68 (s, 2H), 1.48 (s, 9H). LCMS: m/z 378.2 [M+Na]⁺.

### B. Step 2

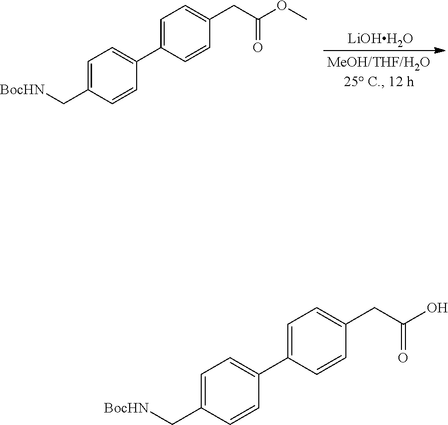 [SMILES: COC(=O)Cc1ccc(-c2ccc(CNC(=O)OC(C)(C)C)cc2)cc1 ; "LiOH·H2O" ; CC(C)(C)OC(=O)NCc1ccc(-c2ccc(CC(=O)O)cc2)cc1]

To a solution of methyl 2-[4-[4-[(tert-butoxycarbonylamino)methyl]phenyl]phenyl]acetate (2 g, 5.63 mmol) in THF (6 mL), H₂O (6 mL) and MeOH (6 mL) was added LiOH·H₂O (708.39 mg, 16.88 mmol) at 25° C. The mixture was stirred at 25° C. for 12 hours. The pH of the reaction mixture was adjusted to 7 by addition of 1 M aqueous HCl solution. The reaction mixture was diluted with water (10 mL) and extracted with Dichloromethane/Methanol (10/1, 15 mL×3). The combined organic layer was washed with brine (30 mL×3), dried over anhydrous Na₂SO₄, filtered and concentrated in vacuo to afford the desired product 2-[4-[4-[(tert-butoxycarbonylamino)methyl]phenyl]phenyl]acetic acid (1.6 g, 4.49 mmol, 79.78% yield, 95.79% purity) as pale yellow solid. ¹H NMR: CDCl₃, 400 MHz. δ 12.35 (brs, 1H), 7.64-7.54 (m, 4H), 7.42-7.40 (m, 1H), 7.36-7.28 (m, 4H), 4.16 (d, J=6.0 Hz, 2H), 3.33 (s, 2H), 1.40 (s, 9H). LCMS: m/z 364.2 [M+Na]⁺.

### C. Step 3

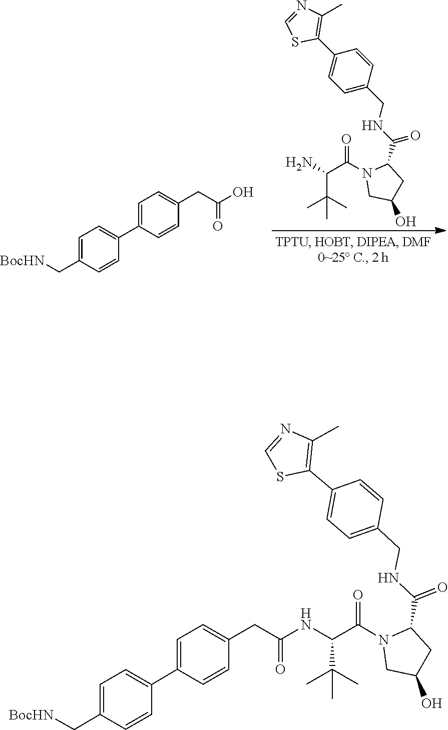 [SMILES: CC(C)(C)OC(=O)NCc1ccc(-c2ccc(CC(=O)O)cc2)cc1 ; Cc1ncsc1-c1ccc(CNC(=O)[C@@H]2C[C@@H](O)CN2C(=O)[C@@H](N)C(C)(C)C)cc1 ; Cc1ncsc1-c1ccc(CNC(=O)[C@@H]2C[C@@H](O)CN2C(=O)[C@@H](NC(=O)Cc2ccc(-c3ccc(CNC(=O)OC(C)(C)C)cc3)cc2)C(C)(C)C)cc1]

To a mixture of (2S,4R)-1-[(2S)-2-amino-3,3-dimethyl-butanoyl]-4-hydroxy-N-[[4-(4-methylthiazol-5-yl)phenyl]methyl]pyrrolidine-2-carboxamide (500 mg, 1.07 mmol), DIEA (553.48 mg, 4.28 mmol, 745.92 μL) and 2-[4-[4-[(tert-butoxycarbonylamino)methyl]phenyl]phenyl]acetic acid (438.61 mg, 1.28 mmol) in DMF (8 mL) was added TPTU (636.07 mg, 2.14 mmol) and HOBt (289.33 mg, 2.14 mmol) at 0° C. The mixture was warmed to 25° C. and stirred for 2 hours. The reaction mixture was diluted with water (5 mL) and extracted with ethyl acetate (5 mL×3). The combined organic layer was washed with brine (10 mL×3), dried over anhydrous Na₂SO₄, filtered and concentrated in vacuo. The residue was purified by preparative TLC on silica gel (Dichloromethane/Methanol=10/1) to afford the desired product tert-butyl N-[[4-[4-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethyl]phenyl]phenyl]methyl]carbamate (550 mg, 701.77 μmol, 65.55% yield, 96.2% purity) as a brown oil. LCMS: m/z 754.4 [M+H]⁺.

### D. Step 4

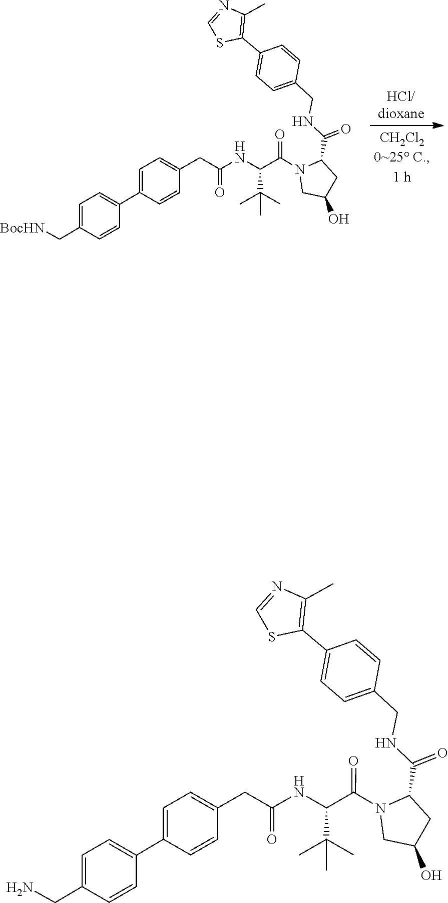 [SMILES: Cc1ncsc1-c1ccc(CNC(=O)[C@@H]2C[C@@H](O)CN2C(=O)[C@@H](NC(=O)Cc2ccc(-c3ccc(CNC(=O)OC(C)(C)C)cc3)cc2)C(C)(C)C)cc1 ; Cc1ncsc1-c1ccc(CNC(=O)[C@@H]2C[C@@H](O)CN2C(=O)[C@@H](NC(=O)Cc2ccc(-c3ccc(CN)cc3)cc2)C(C)(C)C)cc1]

To a mixture of tert-butyl N-[[4-[4-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethyl]phenyl]phenyl]methyl]carbamate (200 mg, 265.27 μmol) in CH₂Cl₂ (2 mL) was added HCl/dioxane (4 M in dioxane, 6.4 mmol, 1.60 mL) at 0° C. The mixture was warmed to 25° C. and stirred for 1 hour. The reaction mixture was concentrated in vacuo to afford the desired product (2S,4R)-1-[(2S)-2-[[2-[4-[4-(aminomethyl)phenyl]phenyl]acetyl]amino]-3,3-dimethyl-butanoyl]-4-hydroxy-N-[[4-(4-methylthiazol-5-yl)phenyl]methyl]pyrrolidine-2-carboxamide (180 mg, crude, HCl salt) as a yellow solid. LCMS: m/z 654.4 [M+H]⁺.

### E. Step 5

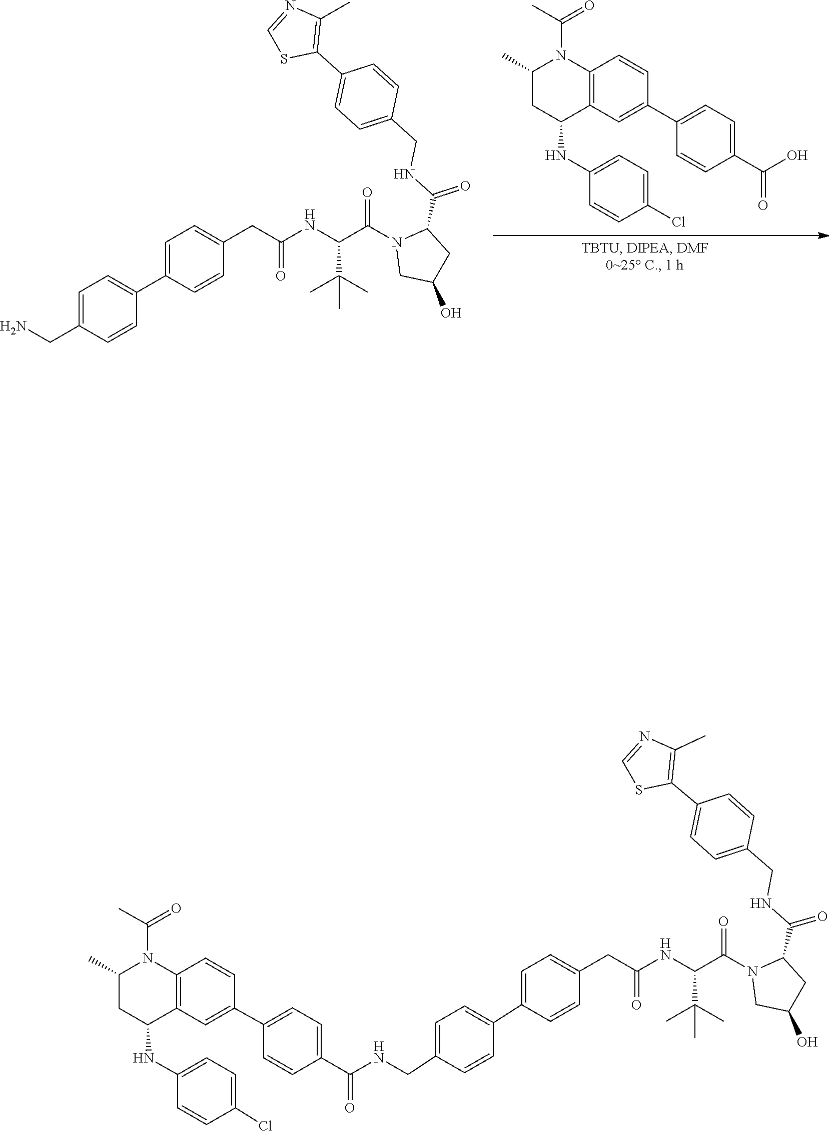 [SMILES: Cc1ncsc1-c1ccc(CNC(=O)[C@@H]2C[C@@H](O)CN2C(=O)[C@@H](NC(=O)Cc2ccc(-c3ccc(CN)cc3)cc2)C(C)(C)C)cc1 ; CC(=O)N1c2ccc(-c3ccc(C(=O)O)cc3)cc2[C@H](Nc2ccc(Cl)cc2)C[C@@H]1C ; CC(=O)N1c2ccc(-c3ccc(C(=O)NCc4ccc(-c5ccc(CC(=O)N[C@H](C(=O)N6C[C@H](O)C[C@H]6C(=O)NCc6ccc(-c7scnc7C)cc6)C(C)(C)C)cc5)cc4)cc3)cc2[C@H](Nc2ccc(Cl)cc2)C[C@@H]1C]

To a mixture of 4-[(2S,4R)-1-acetyl-4-(4-chloroanilino)-2-methyl-3,4-dihydro-2H-quinolin-6-yl]benzoic acid (80 mg, 183.94 μmol), DIEA (95.09 mg, 735.78 μmol, 128.16 μL) and (2S,4R)-1-[(2S)-2-[[2-[4-[4-(aminomethyl)phenyl]phenyl]acetyl]amino]-3,3-dimethyl-butanoyl]-4-hydroxy-N-[[4-(4-methylthiazol-5-yl)phenyl]methyl]pyrrolidine-2-carboxamide (126.98 mg, 183.94 μmol, HCl salt) in DMF (2 mL) was added TBTU (118.12 mg, 367.89 μmol) at 0° C. The mixture was warmed to 25° C. and stirred for 1 hour. The reaction mixture was diluted with water (5 mL) and extracted with Dichloromethane/Methanol (10/1, 5 mL×3). The combined organic layer were washed with brine (10 mL×3), dried over anhydrous Na₂SO₄, filtered and concentrated in vacuo. The residue was purified by preparative HPLC (column: Phenomenex luna C18 150*25 mm*10 um; mobile phase: [water (FA)-ACN]; gradient: 50%-80% B over 10 min) to afford the desired product (2S,4R)-1-[(2S)-2-[[2-[4-[4-[[[4-[(2S,4R)-1-acetyl-4-(4-chloroanilino)-2-methyl-3,4-dihydro-2H-quinolin-6-yl]benzoyl]amino]methyl]phenyl]phenyl]acetyl]amino]-3,3-dimethyl-butanoyl]-4-hydroxy-N-[[4-(4-methylthiazol-5-yl)phenyl]methyl]pyrrolidine-2-carboxamide (81.27 mg, 75.10 μmol, 40.83% yield, 98.95% purity) as a white solid. ¹H NMR: DMSO-d₆, 400 MHz. δ 9.08 (t, J=5.6 Hz, 1H), 8.98 (s, 1H), 8.61-8.53 (m, 1H), 8.15 (d, J=9.2 Hz, 1H), 7.99-7.92 (m, 2H), 7.65-7.54 (m, 7H), 7.46-7.32 (m, 10H), 7.15-7.09 (m, 2H), 6.77-6.70 (m, 2H), 6.29 (d, J=8.0 Hz, 1H), 5.12 (d, J=3.6 Hz, 1H), 4.75-4.66 (m, 1H), 4.54-4.50 (m, 2H), 4.47-4.39 (m, 2H), 4.35-4.26 (m, 2H), 4.24-4.18 (m, 1H), 3.71-3.61 (m, 3H), 3.50-3.47 (m, 1H), 2.65-2.56 (m, 2H), 2.44 (s, 3H), 2.14 (s, 3H), 2.06-1.97 (m, 1H), 1.93-1.85 (m, 1H), 1.27-1.20 (m, 1H), 1.09 (d, J=6.4 Hz, 3H), 0.92 (s, 9H). LCMS: m/z 1070.7 [M+H]⁺.

### Example C-7. Synthesis of (2S,4R)-1-[(2S)-2-[[2-[4-[5-[[4-[(2S,4R)-1-acetyl-4-(4-chloroanilino)-2-methyl-3,4-dihydro-2H-quinolin-6-yl]benzoyl]amino]pentyl]piperazin-1-yl]acetyl]amino]-3,3-dimethyl-butanoyl]-4-hydroxy-n-[[4-(4-methylthiazol-5-yl)phenyl]methyl]pyrrolidine-2-carboxamide

### A. Step 1

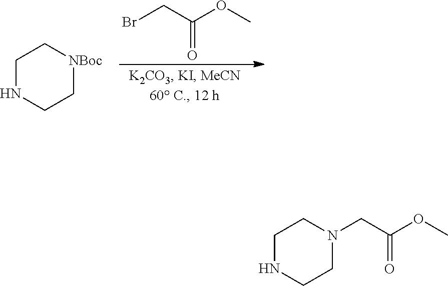

To a solution of tert-butyl piperazine-1-carboxylate (3 g, 16.11 mmol), methyl 2-bromoacetate (3.20 g, 20.94 mmol, 1.98 mL) in MeCN (80 mL) was added KI (2.67 g, 16.11 mmol) and Cs₂CO₃ (10.50 g, 32.21 mmol) at 25° C. The mixture was heated to 60° C. and stirred for 12 hours. The reaction mixture was diluted with water (50 mL) and extracted with Ethyl acetate (40 mL×3). The combined phase was washed with brine (40 mL×3), dried over anhydrous Na₂SO₄, filtered and concentrated in vacuo. The residue was purified by column chromatography on silica gel (Petroleum ether/Ethyl acetate=2/1) to afford the desired product tert-butyl 4-(2-methoxy-2-oxo-ethyl)piperazine-1-carboxylate (2.68 g, 10.38 mmol, 64.41% yield) as a yellow oil. ¹H NMR: CDCl₃, 400 MHz. 33.74 (s, 3H), 3.53-3.47 (m, 4H), 3.26 (s, 2H), 2.56-2.53 (m, 4H), 1.47 (s, 9H).

### B. Step 2

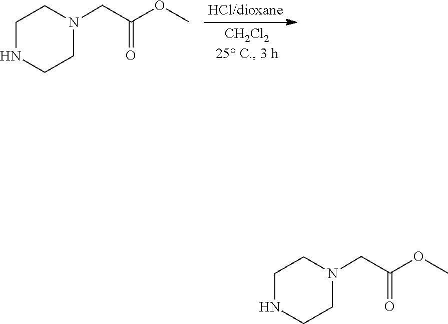

To a solution of tert-butyl 4-(2-methoxy-2-oxo-ethyl)piperazine-1-carboxylate (2.68 g, 10.38 mmol) in CH₂Cl₂ (10 mL) was added HCl/dioxane (4 M in dioxane, 40.0 mmol, 10 mL). The mixture was stirred at 25° C. for 3 hours. The reaction mixture was concentrated in vacuo to afford the desired product methyl 2-piperazin-1-ylacetate (2 g, 10.27 mmol, 99.03% yield, HCl salt) as a yellow solid. ¹H NMR: DMSO-d₆, 400 MHz. 39.65 (s, 2H), 4.06 (s, 2H), 3.71 (s, 3H), 3.36-3.33 (m, 8H).

### C. Step 3

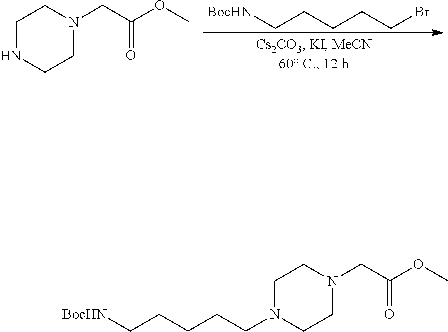 [SMILES: COC(=O)CN1CCNCC1 ; CC(C)(C)OC(=O)NCCCCCBr ; COC(=O)CN1CCN(CCCCCNC(=O)OC(C)(C)C)CC1]

To a solution of methyl 2-piperazin-1-ylacetate (2 g, 10.27 mmol, HCl salt) and tert-butyl N-(5-bromopentyl)carbamate (3.56 g, 13.36 mmol) in MeCN (50 mL) was added Cs₂CO₃ (6.70 g, 20.55 mmol), KI (1.71 g, 10.27 mmol) at 25° C. The mixture was heated to 60° C. and stirred for 12 hours under N₂. The reaction mixture was diluted with water (3 mL) and extracted with Ethyl acetate (5 mL×3). The combined phase was washed with brine (10 mL×3), dried over anhydrous Na₂SO₄, filtered and concentrated in vacuo. The residue was purified by column chromatography on silica gel (Dichloromethane/Methanol=10/1) to afford the desired product methyl 2-[4-[5-(tert-butoxycarbonylamino)pentyl]piperazin-1-yl]acetate (3.2 g, 9.32 mmol, 90.68% yield) as a light yellow oil. ¹H NMR: CDCl₃, 400 MHz. 34.54 (brs, 1H), 3.73 (s, 3H), 3.23 (s, 2H), 3.14-3.07 (m, 2H), 2.68-2.57 (m, 6H), 2.44-2.36 (m, 2H), 1.59-1.47 (m, 6H), 1.45 (s, 9H), 1.37-1.30 (m, 2H). LCMS: m/z 344.3 [M+H]⁺.

### D. Step 4

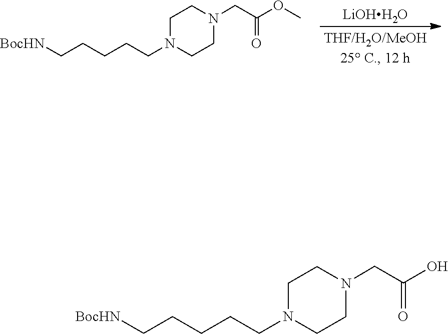

To a solution of methyl 2-[4-[5-(tert-butoxycarbonylamino)pentyl]piperazin-1-yl]acetate (3.2 g, 9.32 mmol) in THF (10 mL), H₂O (10 mL) and MeOH (10 mL) was added LiOH H₂O (1.56 g, 37.27 mmol). The mixture was stirred at 25° C. for 12 hours. The reaction mixture concentrated in vacuo. The pH of the mixture was adjusted to 6 by 2M aqueous HCl solution. The residue was purified by preparative HPLC (column: YMC Triart C18 70*250 mm*7 um; mobile phase: [water (NH₄HCO₃)-ACN]; gradient: 5%-35% B over 20 min) to afford the desired product 2-[4-[5-(tert-butoxycarbonylamino)pentyl]piperazin-1-yl]acetic acid (2.5 g, 7.59 mmol, 81.45% yield) as a yellow oil. ¹H NMR: DMSO-d₆, 400 MHz. 36.75 (t, J=10.8 Hz, 1H), 3.12 (s, 2H), 2.30-2.87 (m, 2H), 2.67-2.64 (m, 4H), 2.41-2.38 (m, 4H), 2.24-2.21 (m, 2H), 1.42-1.37 (m, 4H), 1.36 (s, 9H), 1.25-1.16 (m, 2H). LCMS: m/z 330.2 [M+H]⁺.

### E. Step 5

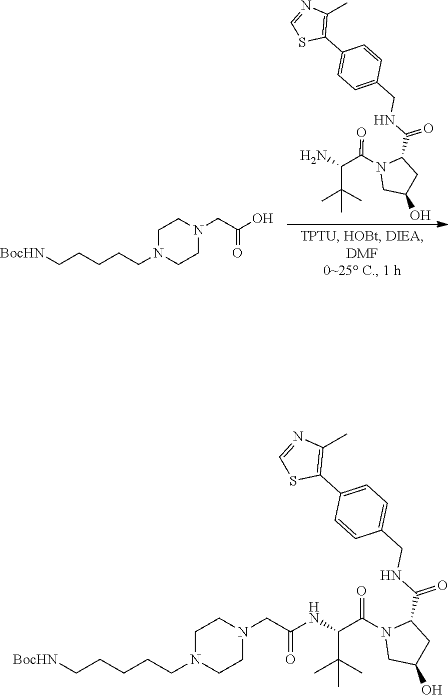 [SMILES: Cc1ncsc1-c1ccc(CNC(=O)[C@@H]2C[C@@H](O)CN2C(=O)[C@@H](N)C(C)(C)C)cc1 ; CC(C)(C)OC(=O)NCCCCCN1CCN(CC(=O)O)CC1 ; Cc1ncsc1-c1ccc(CNC(=O)[C@@H]2C[C@@H](O)CN2C(=O)[C@@H](NC(=O)CN2CCN(CCCCCNC(=O)OC(C)(C)C)CC2)C(C)(C)C)cc1]

To a solution of (2S,4R)-1-[(2S)-2-amino-3,3-dimethyl-butanoyl]-4-hydroxy-N-[[4-(4-methylthiazol-5-yl)phenyl]methyl]pyrrolidine-2-carboxamide (350 mg, 749.43 μmol, HCl salt) and 2-[4-[5-(tert-butoxycarbonylamino)pentyl]piperazin-1-yl]acetic acid (350.00 mg, 1.06 mmol) in DMF (3 mL) were added DIEA (387.43 mg, 3.00 mmol, 522.15 μL), TPTU (445.25 mg, 1.50 mmol) and HOBt (202.53 mg, 1.50 mmol) at 0° C. The mixture was stirred at 25° C. for 1 hour. The reaction mixture was diluted with water (3 mL) and extracted with Dichloromethane/Methanol (10/1, 5 mL×3). The combined phase was washed with brine (10 mL×3), dried over anhydrous Na₂SO₄, filtered and concentrated in vacuo. The residue was purified by preparative HPLC (column: Daisogel SP ODS RPS 150*25 mm*5 um; mobile phase: [water (NH₄HCO₃)-ACN]; gradient: 35%-65% B over 10 min) to afford the desired product tert-butyl N-[5-[4-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethyl]piperazin-1-yl]pentyl]carbamate (240 mg, 323.46 μmol, 43.16% yield) as a light yellow solid. LCMS: m/z 742.4[M+H]⁺.

### F. Step 6

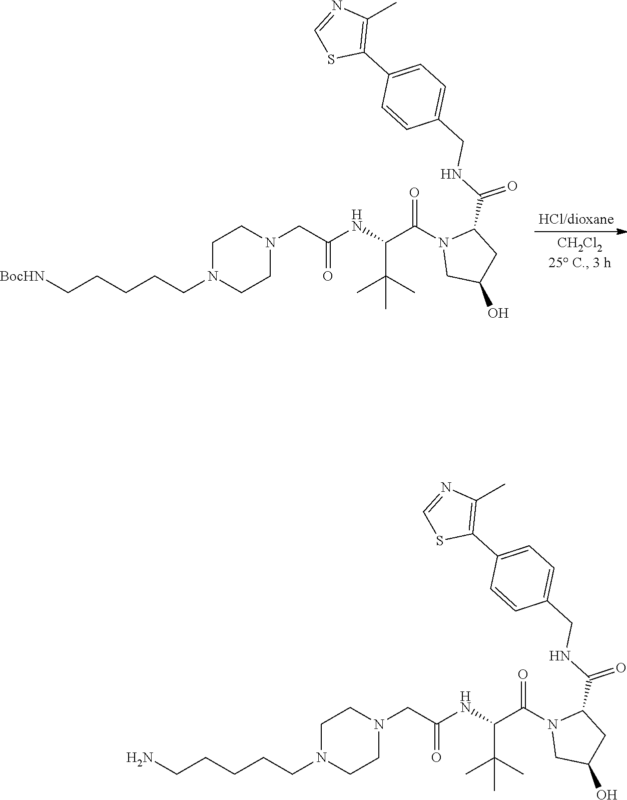 [SMILES: Cc1ncsc1-c1ccc(CNC(=O)[C@@H]2C[C@@H](O)CN2C(=O)[C@@H](NC(=O)CN2CCN(CCCCCNC(=O)OC(C)(C)C)CC2)C(C)(C)C)cc1 ; Cc1ncsc1-c1ccc(CNC(=O)[C@@H]2C[C@@H](O)CN2C(=O)[C@@H](NC(=O)CN2CCN(CCCCCN)CC2)C(C)(C)C)cc1]

To a solution of tert-butyl N-[5-[4-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethyl]piperazin-1-yl]pentyl]carbamate (240 mg, 323.46 μmol) in CH₂Cl₂ (4 mL) was added HCl/dioxane (4 M in dioxane, 16.0 mmol, 4.0 mL). The mixture was stirred at 25° C. for 1 hour. The reaction mixture was concentrated in vacuo to afford the desired product (2S,4R)-1-[(2S)-2-[[2-[4-(5-aminopentyl)piperazin-1-yl]acetyl]amino]-3,3-dimethyl-butanoyl]-4-hydroxy-N-[[4-(4-methylthiazol-5-yl)phenyl]methyl]pyrrolidine-2-carboxamide (242 mg, 322.13 mol, 99.59% yield, 3HCl salt) as a light yellow solid. LCMS: m/z 642.3 [M+H]⁺.

### G. Step 7

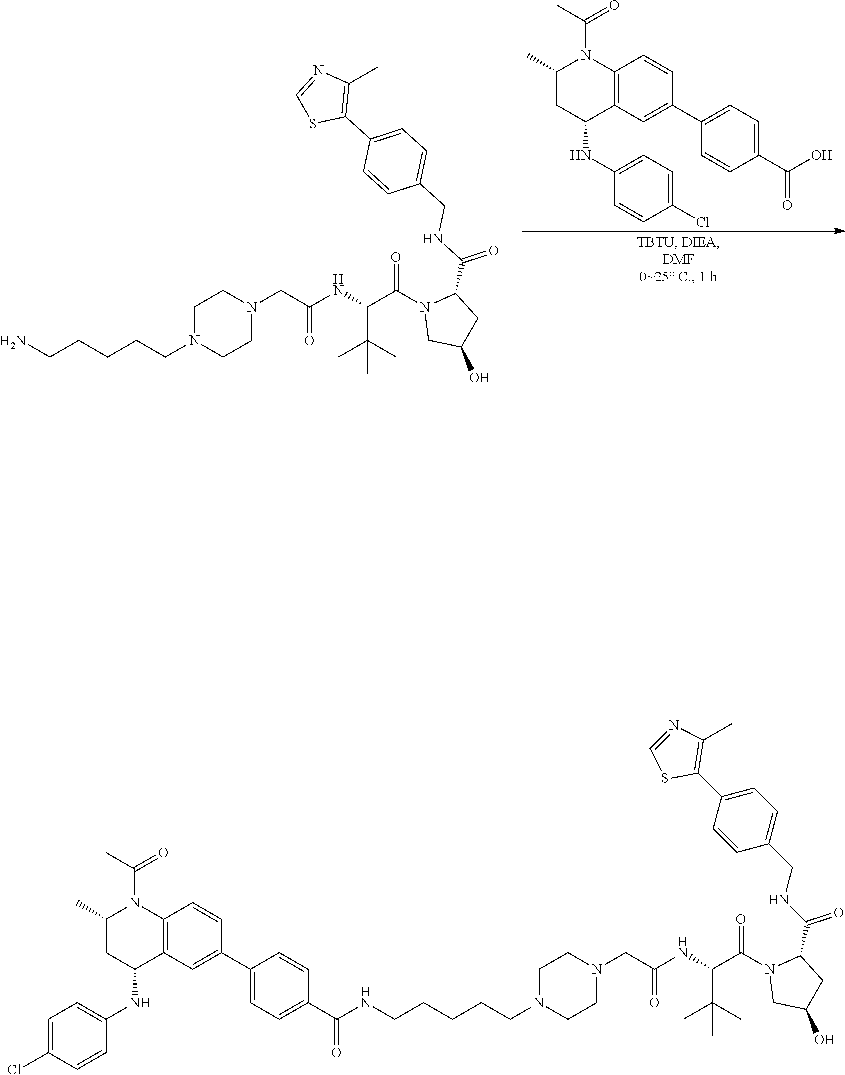 [SMILES: Cc1ncsc1-c1ccc(CNC(=O)[C@@H]2C[C@@H](O)CN2C(=O)[C@@H](NC(=O)CN2CCN(CCCCCN)CC2)C(C)(C)C)cc1 ; CC(=O)N1c2ccc(-c3ccc(C(=O)O)cc3)cc2[C@H](Nc2ccc(Cl)cc2)C[C@@H]1C ; CC(=O)N1c2ccc(-c3ccc(C(=O)NCCCCCN4CCN(CC(=O)N[C@H](C(=O)N5C[C@H](O)C[C@H]5C(=O)NCc5ccc(-c6scnc6C)cc5)C(C)(C)C)CC4)cc3)cc2[C@H](Nc2ccc(Cl)cc2)C[C@@H]1C]

To a solution of (2S,4R)-1-[(2S)-2-[[2-[4-(5-aminopentyl)piperazin-1-yl]acetyl]amino]-3,3-dimethyl-butanoyl]-4-hydroxy-N-[[4-(4-methylthiazol-5-yl)phenyl]methyl]pyrrolidine-2-carboxamide (122 mg, 162.40 μmol, 3HCl salt), DIEA (83.21 mg, 643.81 μmol, 112.14 μL) and 4-[(2S,4R)-1-acetyl-4-(4-chloroanilino)-2-methyl-3,4-dihydro-2H-quinolin-6-yl]benzoic acid (70 mg, 160.95 μmol) in DMF (1 mL) was added TBTU (103.36 mg, 321.90 μmol) at 0° C. The mixture was stirred at 25° C. for 1 hour. The reaction mixture was diluted with water (3 mL) and extracted with Dichloromethane/Methanol (10/1, 5 mL×3). The combined phase was washed with brine (10 mL×3), dried over anhydrous Na₂SO₄, filtered and concentrated in vacuo. The residue was purified by preparative HPLC (column: Welch Ultimate C18 150*25 mm*5 um; mobile phase: [water (FA)-ACN]; gradient: 20%-50% B over 10 min) to afford the desired product (2S,4R)-1-[(2S)-2-[[2-[4-[5-[[4-[(2S,4R)-1-acetyl-4-(4-chloroanilino)-2-methyl-3,4-dihydro-2H-quinolin-6-yl]benzoyl]amino]pentyl]piperazin-1-yl]acetyl]amino]-3,3-dimethyl-butanoyl]-4-hydroxy-N-[[4-(4-methylthiazol-5-yl)phenyl]methyl]pyrrolidine-2-carboxamide (56.29 mg, 51.80 μmol, 32.18% yield, 97.42% purity) as a white solid. ¹H NMR: DMSO-d₆, 400 MHz. δ 8.98 (s, 1H), 8.61-8.59 (m, 1H), 8.51-8.35 (m, 1H), 7.88 (d, J=8.0 Hz, 2H), 7.81-7.69 (m, 1H), 7.65-7.55 (m, 3H), 7.48-7.34 (m, 6H), 7.12 (d, J=8.4 Hz, 2H), 6.74 (d, J=8.8 Hz, 2H), 6.30 (d, J=8.0 Hz, 1H), 5.21-5.04 (m, 1H), 4.80-4.60 (m, 1H), 4.50-4.23 (m, 6H), 3.66-3.58 (m, 2H), 3.26-3.22 (m, 4H), 3.01-2.90 (m, 2H), 2.67-2.57 (m, 2H), 2.44 (s, 3H), 2.40-2.31 (m, 3H), 2.26-2.20 (m, 2H), 2.14 (s, 3H), 2.08-2.00 (m, 1H), 1.94-1.83 (m, 1H), 1.53-1.36 (m, 4H), 1.35-1.16 (m, 4H), 1.09 (d, J=6.0 Hz, 3H), 0.93 (s, 9H). LCMS: m/z 1058.7 [M+H]⁺.

### Example C-8. Synthesis of 8-(3,5-difluoro-2-pyridyl)-N-[8-[5-[(1R)-1-[(2S,4R)-4-hydroxy-2-[[4-(4-methylthiazol-5-yl)phenyl]methylcarbamoyl]pyrrolidine-1-carbonyl]-2-methyl-propyl]isoxazol-3-yl]oxyoctyl]-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxamide

### A. Step 1

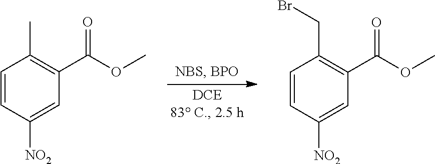

To a solution of methyl 2-methyl-5-nitro-benzoate (45 g, 230.57 mmol) in DCE (1000 mL) was added NBS (45.14 g, 253.62 mmol) and BPO (5.59 g, 23.06 mmol). The mixture was stirred at 83° C. for 2.5 hours. The mixture was concentrated in vacuo. The mixture was triturated with Petroleum ether/Ethyl acetate (20/1, 200 mL). The resultant precipitate solid was collected by filtration, washed with methanol (40 mL*3) and dried in vacuo to afford the desired product methyl 2-(bromomethyl)-5-nitro-benzoate (32 g, 116.76 mmol, 50.64% yield) as a white solid. ¹H NMR: CDCl₃, 400 MHz. δ 8.81 (s, 1H), 8.33 (d, J=8.4 Hz, 1H), 7.69 (d, J=8.4 Hz, 1H), 5.00 (s, 2H), 4.01 (s, 3H).

### B. Step 2

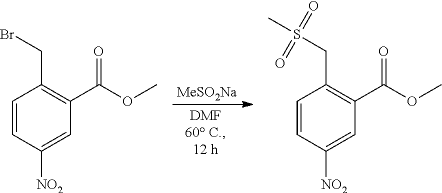

A mixture of methyl 2-(bromomethyl)-5-nitro-benzoate (32 g, 116.76 mmol) and sodium; methanesulfinate (23.84 g, 233.52 mmol) in DMF (500 mL) was heated to 60° C. and stirred for 12 hours. The mixture was diluted with water (400 mL) and extracted with ethyl acetate (500 mL×3). The combined organic phase was washed with brine (300 mL×3), dried over anhydrous Na₂SO₄, filtered and concentrated in vacuo. The residue was purified by column chromatography on silica gel (Petroleum ether/Ethyl acetate=1/1) to afford the desired product methyl 2-(methylsulfonylmethyl)-5-nitro-benzoate (25 g, 91.49 mmol, 78.36% yield) as a yellow solid. ¹H NMR: CDCl₃, 400 MHz. δ 8.80 (s, 1H), 8.35-8.31 (m, 1H), 7.73 (d, J=8.4 Hz, 1H), 4.99 (s, 2H), 3.94 (s, 3H), 2.85 (s, 3H).

### C. Step 3

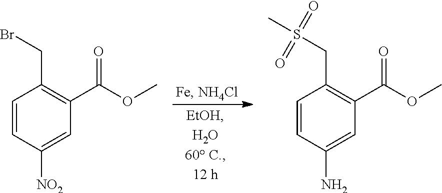

To a solution of methyl 2-(methylsulfonylmethyl)-5-nitro-benzoate (25 g, 91.49 mmol) in H₂O (225 mL) and EtOH (900 mL) was added Fe (25.55 g, 457.44 mmol) and NH₄Cl (24.47 g, 457.44 mmol) at 25° C. The mixture was heated to 60° C. and stirred for 12 hours. The mixture was filtered and the filtrate was concentrated in vacuo. The mixture was diluted with water (100 mL) and extracted with ethyl acetate (200 mL×3). The combined organic phase was washed with brine (200 mL×3), dried over anhydrous Na₂SO₄, filtered and concentrated in vacuo to afford the desired product methyl 5-amino-2-(methylsulfonylmethyl)benzoate (22 g, 90.43 mmol, 98.85% yield) as a yellow solid. ¹H NMR: CDCl₃, 400 MHz. δ 7.36-7.28 (m, 2H), 6.86-6.83 (m, 1H), 4.75 (s, 2H), 3.90 (s, 3H), 2.76 (s, 3H).

### D. Step 4

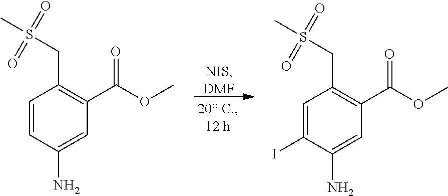

To a solution of methyl 5-amino-2-(methylsulfonylmethyl)benzoate (5 g, 20.55 mmol) in DMF (100 mL) was added NIS (5.09 g, 22.61 mmol) at 20° C. The mixture was stirred for 12 hours. The mixture was diluted with water (300 mL) and extracted with ethyl acetate (300 mL×3). The combined organic phase was washed with brine (300 mL×3), dried over anhydrous Na₂SO₄, filtered and concentrated in vacuo. The residue was purified by column chromatography on silica gel (Petroleum ether/Ethyl acetate=2/1). The mixture was triturated in MeOH (50 mL). The resultant precipitate solid was collected by filtration and dried in vacuo to afford the desired product methyl 5-amino-4-iodo-2-(methylsulfonylmethyl)benzoate (13.1 g, 35.48 mmol, 43.16% yield) as a yellow solid. ¹H NMR: DMSO-d₆, 400 MHz. δ 7.72 (s, 1H), 7.25 (s, 1H), 5.68 (s, 2H), 4.70 (s, 2H), 3.78 (s, 3H), 2.81 (s, 3H).

### E. Step 5

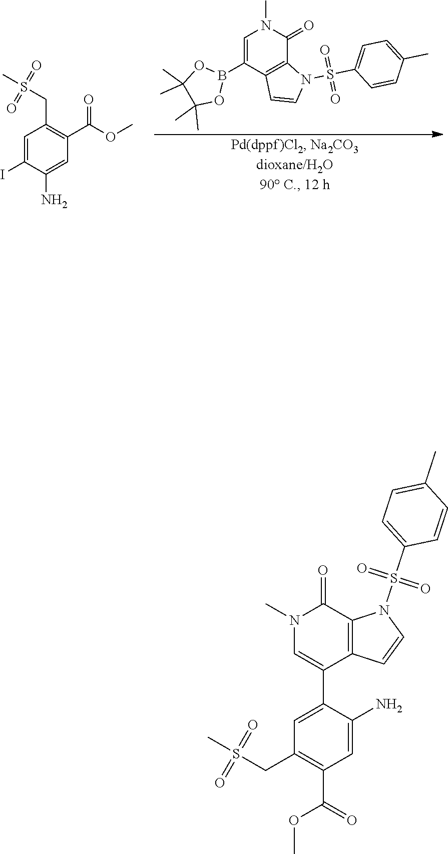

A mixture of methyl 5-amino-4-iodo-2-(methylsulfonylmethyl)benzoate (2.6 g, 7.04 mmol), 6-methyl-1-(ptolylsulfonyl)-4-(4,4,5,5-tetramethyl-1,3,2-dioxaborolan-2-yl)pyrrolo[2,3-c]pyridin-7-one (3.02 g, 7.04 mmol), Na₂CO₃ (1.49 g, 14.09 mmol) and Pd(dppf)Cl₂ (515.32 mg, 704.27 μmol) in dioxane (25 mL) and H₂O (5 mL) was heated to 90° C. and stirred for 12 hours under N₂. The reaction mixture was diluted with water (20 mL). The resultant precipitate solid was collected by filtration and dried in vacuo to afford the desired product methyl 5-amino-4-[6-methyl-7-oxo-1-(p-tolylsulfonyl)pyrrolo[2,3-c]pyridin-4-yl]-2-(methylsulfonylmethyl)benzoate (1.6 g, 2.94 mmol, 41.79% yield) as an orange solid. ¹H NMR: DMSO-d₆, 400 MHz. δ 8.05-7.91 (m, 3H), 7.52-7.39 (m, 3H), 7.31 (s, 1H), 7.15 (s, 1H), 6.36 (s, 1H), 5.43 (s, 2H), 4.74 (s, 2H), 3.81 (s, 3H), 3.44 (s, 3H), 2.82 (s, 3H), 2.39 (s, 3H). LCMS: m/z 544.0 [M+H]⁺.

### F. Step 6

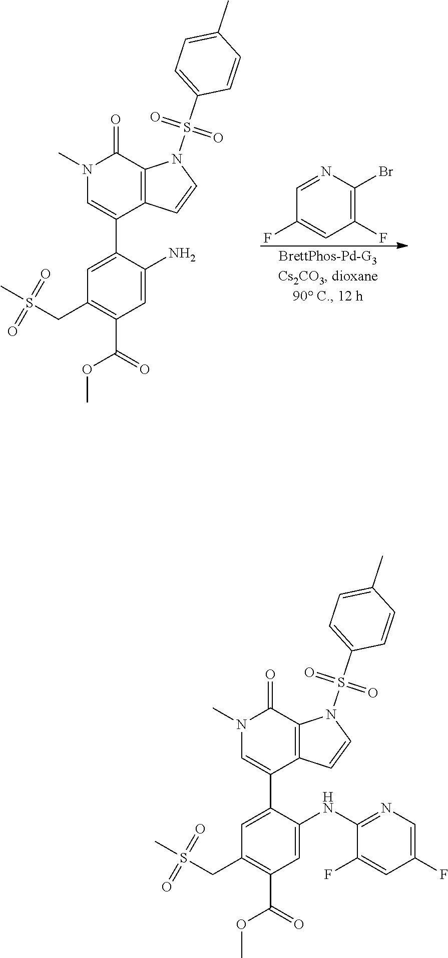 [SMILES: COC(=O)c1cc(N)c(-c2cn(C)c(=O)c3c2ccn3S(=O)(=O)c2ccc(C)cc2)cc1CS(C)(=O)=O ; Fc1cnc(Br)c(F)c1 ; COC(=O)c1cc(Nc2ncc(F)cc2F)c(-c2cn(C)c(=O)c3c2ccn3S(=O)(=O)c2ccc(C)cc2)cc1CS(C)(=O)=O]

A mixture of methyl 5-amino-4-[6-methyl-7-oxo-1-(p-tolylsulfonyl)pyrrolo[2,3-c]pyridin-4-yl]-2-(methylsulfonylmethyl)benzoate (1.6 g, 2.94 mmol), 2-bromo-3,5-difluoro-pyridine (1.71 g, 8.83 mmol), [2-(2-aminophenyl)phenyl]-methylsulfonyloxy-palladium; dicyclohexyl-[3,6-dimethoxy-2-(2,4,6-triisopropylphenyl)phenyl]phosphane (533.62 mg, 588.66 μmol) and Cs₂CO₃ (1.92 g, 5.89 mmol) in dioxane (20 mL) was heated to 90° C. and stirred for 12 hours under N₂. The reaction mixture was diluted with water (20 mL). The resultant precipitate solid was collected by filtration and dried in vacuo to afford the desired product methyl 5-[(3,5-difluoro-2-pyridyl)amino]-4-[6-methyl-7-oxo-1-(p-tolylsulfonyl)pyrrolo[2,3-c]pyridin-4-yl]-2-(methylsulfonylmethyl)benzoate (1.8 g, 2.74 mmol, 93.13% yield) as a gray solid. ¹H NMR: DMSO-d₆, 400 MHz. δ 8.27 (s, 1H), 8.15 (s, 1H), 7.92-7.87 (m, 3H), 7.85 (d, J=2.4 Hz, 1H), 7.73-7.66 (m, 1H), 7.48 (d, J=6.4 Hz, 2H), 7.43 (d, J=8.0 Hz, 2H), 6.30 (d, J=3.6 Hz, 1H), 4.93 (s, 2H), 3.84 (s, 3H), 3.40 (s, 3H), 2.93 (s, 3H), 2.39 (s, 3H). LCMS: m/z 657.2 [M+H]⁺.

### G. Step 7

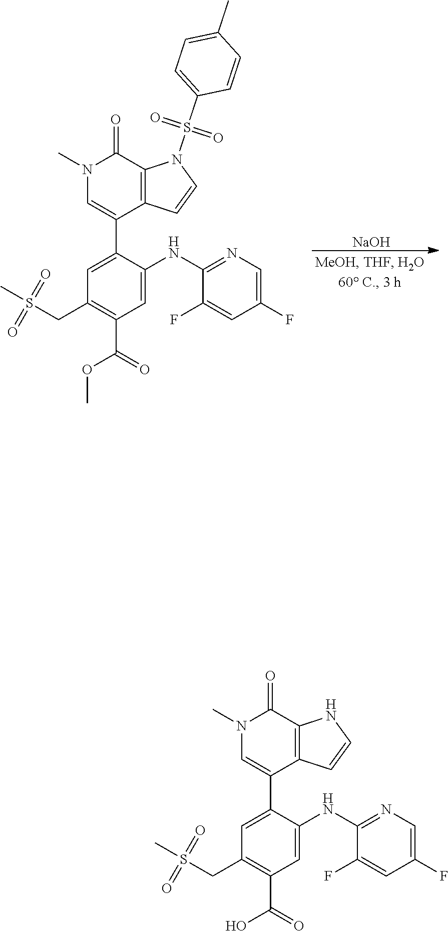 [SMILES: COC(=O)c1cc(Nc2ncc(F)cc2F)c(-c2cn(C)c(=O)c3c2ccn3S(=O)(=O)c2ccc(C)cc2)cc1CS(C)(=O)=O ; "NaOH" ; Cn1cc(-c2cc(CS(C)(=O)=O)c(C(=O)O)cc2Nc2ncc(F)cc2F)c2cc[nH]c2c1=O]

A mixture of methyl 5-[(3,5-difluoro-2-pyridyl)amino]-4-[6-methyl-7-oxo-1-(p-tolylsulfonyl)pyrrolo[2,3-c]pyridin-4-yl]-2-(methylsulfonylmethyl)benzoate (1.8 g, 2.74 mmol) and NaOH (274.09 mg, 6.85 mmol) in MeOH (5 mL), H₂O (5 mL) and THF (5 mL) was heated to 60° C. and stirred for 3 hours under N₂. The mixture was concentrated in vacuo. The mixture was diluted with water (20 mL). The pH of the aqueous phase was adjusted to 5 by addition of 2 N aqueous HCl solution. The mixture was extracted with ethyl acetate (20 mL×3). The combined organic phase was washed with brine (20 mL×3), dried over anhydrous Na₂SO₄, filtered and concentrated in vacuo to afford the desired product 5-[(3,5-difluoro-2-pyridyl)amino]-4-(6-methyl-7-oxo-1H-pyrrolo[2,3-c]pyridin-4-yl)-2-(methylsulfonylmethyl)benzoic acid (1.20 g, 2.45 mmol, 89.48% yield) as a yellow solid. ¹H NMR: DMSO-d₆, 400 MHz. δ 13.09 (brs, 1H), 12.09 (s, 1H), 8.45 (s, 1H), 7.98-7.95 (m, 1H), 7.89 (s, 1H), 7.78-7.69 (m, 1H), 7.53 (s, 1H), 7.33 (s, 1H), 7.26 (t, J=2.8 Hz, 1H), 6.09-6.05 (m, 1H), 5.01 (s, 2H), 3.53 (s, 3H), 2.92 (s, 3H). LCMS: m/z 489.0 [M+H]⁺.

### H. Step 8

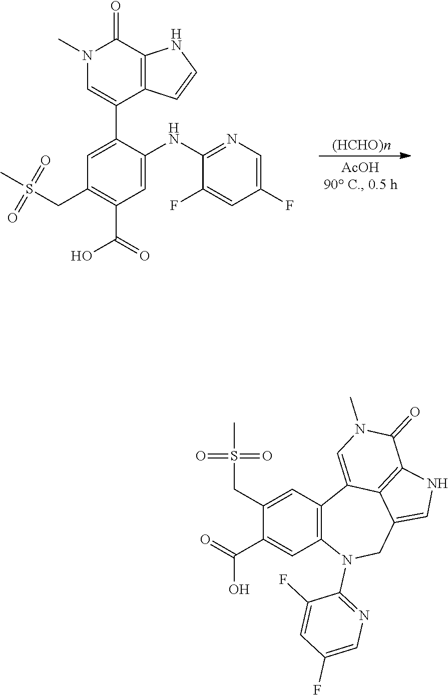 [SMILES: Cn1cc(-c2cc(CS(C)(=O)=O)c(C(=O)O)cc2Nc2ncc(F)cc2F)c2cc[nH]c2c1=O ; "(HCHO)n" ; Cn1cc2c3c(c[nH]c3c1=O)CN(c1ncc(F)cc1F)c1cc(C(=O)O)c(CS(C)(=O)=O)cc1-2]

The mixture of 5-[(3,5-difluoro-2-pyridyl)amino]-4-(6-methyl-7-oxo-1H-pyrrolo[2,3-c]pyridin-4-yl)-2-(methylsulfonylmethyl)benzoic acid (1.2 g, 2.46 mmol), (HCHO)n (600 mg) in AcOH (10 mL) was stirred at 90° C. for 0.5 hour under N₂. The mixture was concentrated in vacuo. The mixture was diluted with water (20 mL). The mixture was extracted with ethyl acetate (20 mL×3). The combined organic phase was washed with brine (20 mL×3), dried over anhydrous Na₂SO₄, filtered and concentrated in vacuo to afford the desired product 8-(3,5-difluoro-2-pyridyl)-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxylic acid (1.05 g, 2.10 mmol, 85.40% yield) as a yellow solid. ¹H NMR: DMSO-d₆, 400 MHz. δ 12.88 (brs, 1H), 11.94 (s, 1H), 8.09 (d, J=2.4 Hz, 1H), 8.00-7.95 (m, 1H), 7.83-7.78 (m, 1H), 7.69-7.60 (m, 1H), 7.60-7.56 (m, 1H), 7.28 (d, J=2.4 Hz, 1H), 6.08-5.71 (m, 1H), 5.34-4.77 (m, 2H), 4.47-4.09 (m, 1H), 3.63 (s, 3H), 2.93 (s, 3H). LCMS: RT=0.350 min, m/z 501.0 [M+H]⁺.

### I. Step 9

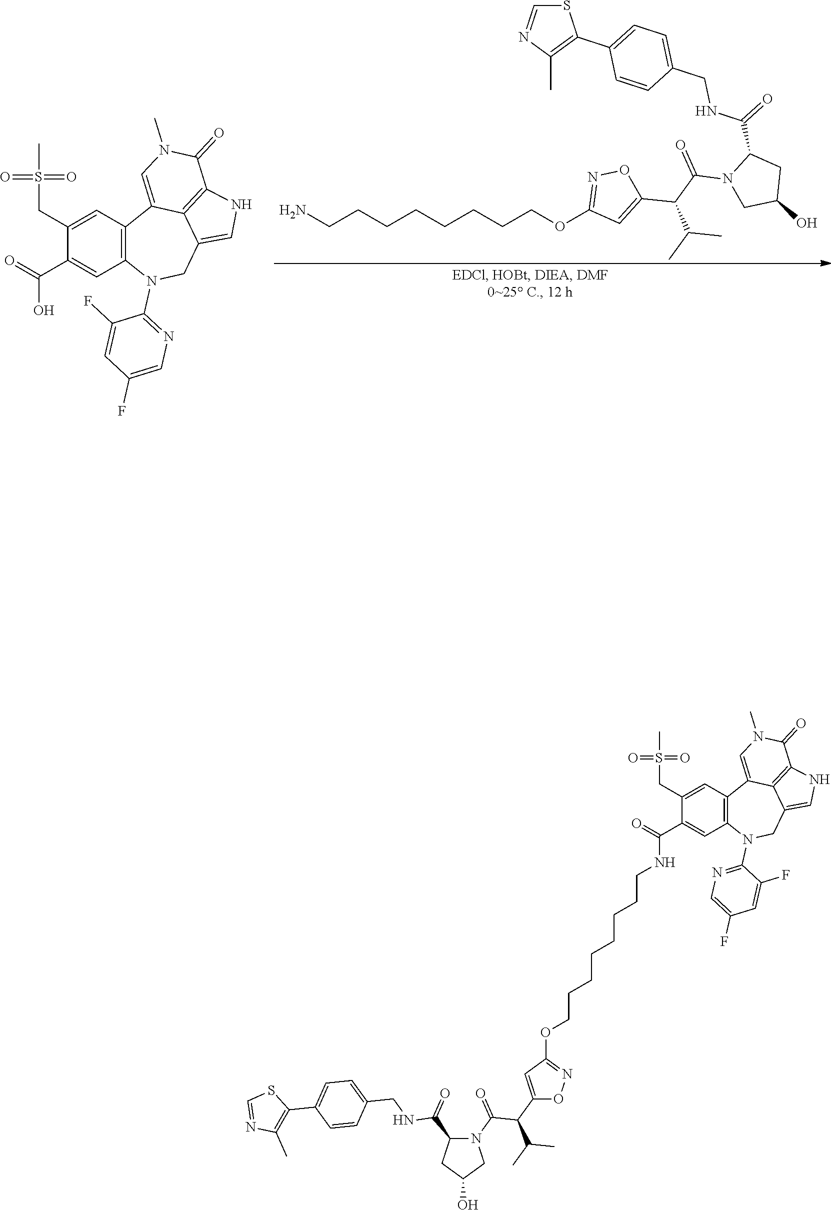 [SMILES: Cn1cc2c3c(c[nH]c3c1=O)CN(c1ncc(F)cc1F)c1cc(C(=O)O)c(CS(C)(=O)=O)cc1-2 ; Cc1ncsc1-c1ccc(CNC(=O)[C@@H]2C[C@@H](O)CN2C(=O)[C@@H](c2cc(OCCCCCCCCN)no2)C(C)C)cc1 ; Cc1ncsc1-c1ccc(CNC(=O)[C@@H]2C[C@@H](O)CN2C(=O)[C@@H](c2cc(OCCCCCCCCNC(=O)c3cc4c(cc3CS(C)(=O)=O)-c3cn(C)c(=O)c5[nH]cc(c35)CN4c3ncc(F)cc3F)no2)C(C)C)cc1]

To a solution of (2S,4R)-1-[(2R)-2-[3-(8-aminooctoxy)isoxazol-5-yl]-3-methyl-butanoyl]-4-hydroxy-N-[[4-(4-methylthiazol-5-yl)phenyl]methyl]pyrrolidine-2-carboxamide (145.03 mg, 199.81 μmol, TFA salt) and 8-(3,5-difluoro-2-pyridyl)-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxylic acid (100 mg, 199.81 μmol) in DMF (2 mL) were added DIEA (103.30 mg, 799.24 μmol, 139.21 μL), HOBt (54.00 mg, 399.62 μmol) and EDCI (76.61 mg, 399.62 μmol) at 0° C. The mixture was warmed to 25° C. and stirred for 12 hours. The mixture was diluted with water (5 mL) and extracted with dichloromethane/methanol (10/1, 5 mL×3). The combined organic phase was washed with brine (5 mL×3), dried over anhydrous Na₂SO₄, filtered and concentrated in vacuo. The residue was purified by preparative HPLC (column: Daisogel SP ODS RPS 150*25 mm*5 um; mobile phase: [water (NH₄HCO₃)-ACN]; gradient: 36%-66% B over 10 min) to afford the desired product 8-(3,5-difluoro-2-pyridyl)-N-[8-[5-[(1R)-1-[(2S,4R)-4-hydroxy-2-[[4-(4-methylthiazol-5-yl)phenyl]methylcarbamoyl]pyrrolidine-1-carbonyl]-2-methyl-propyl]isoxazol-3-yl]oxyoctyl]-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxamide (30.23 mg, 26.39 μmol, 13.21% yield, 95.5% purity) as a white solid. ¹H NMR: DMSO-d₆, 400 MHz. δ 11.92 (s, 1H), 8.98-8.93 (m, 1H), 8.45 (t, J=6.0 Hz, 1H), 8.39 (t, J=5.6 Hz, 1H), 8.07-8.03 (m, 1H), 7.90 (s, 1H), 7.74 (s, 1H), 7.64-7.57 (m, 1H), 7.42-7.37 (m, 2H), 7.33-7.28 (m, 2H), 7.28-7.25 (m, 2H), 6.05-6.02 (m, 1H), 5.12 (d, J=3.6 Hz, 1H), 4.45-4.40 (m, 1H), 4.37-4.19 (m, 4H), 4.13-4.02 (m, 2H), 3.76-3.74 (m, 1H), 3.62 (s, 3H), 3.58-3.53 (m, 1H), 3.42 (m, 4H), 3.16-3.11 (m, 2H), 2.90 (s, 3H), 2.44-2.42 (m, 3H), 2.24 (m, 1H), 2.09-2.01 (m, 1H), 1.94-1.85 (m, 1H), 1.66-1.57 (m, 2H), 1.47-1.40 (m, 2H), 1.28-1.19 (m, 8H), 1.03-0.74 (m, 6H). LCMS: m/z 1094.7 [M+H]⁺.

### Example C-9. Synthesis of 8-(3,5-difluoro-2-pyridyl)-N-[8-[5-[(1S)-1-[(2S,4R)-4-Hydroxy-2-[[4-(4-methylthiazol-5-yl)phenyl]methylcarbamoyl]pyrrolidine-1-carbonyl]-2-methyl-propyl]isoxazol-3-yl]oxyoctyl]-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxamide

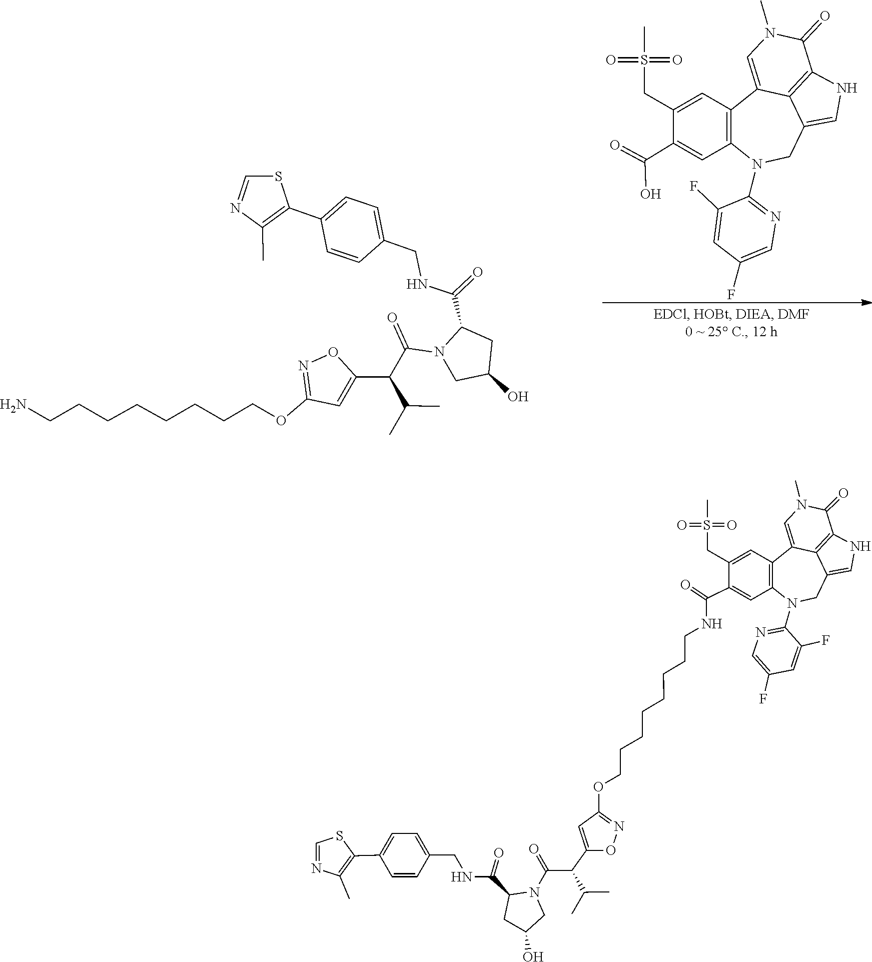 [SMILES: Cc1ncsc1-c1ccc(CNC(=O)[C@@H]2C[C@@H](O)CN2C(=O)[C@H](c2cc(OCCCCCCCCN)no2)C(C)C)cc1 ; Cn1cc2c3c(c[nH]c3c1=O)CN(c1ncc(F)cc1F)c1cc(C(=O)O)c(CS(C)(=O)=O)cc1-2 ; Cc1ncsc1-c1ccc(CNC(=O)[C@@H]2C[C@@H](O)CN2C(=O)[C@H](c2cc(OCCCCCCCCNC(=O)c3cc4c(cc3CS(C)(=O)=O)-c3cn(C)c(=O)c5[nH]cc(c35)CN4c3ncc(F)cc3F)no2)C(C)C)cc1]

To a solution of (2S,4R)-1-[(2S)-2-[3-(8-aminooctoxy)isoxazol-5-yl]-3-methyl-butanoyl]-4-hydroxy-N-[[4-(4-methylthiazol-5-yl)phenyl]methyl]pyrrolidine-2-carboxamide (145.03 mg, 199.81 μmol, TFA salt) and 8-(3,5-difluoro-2-pyridyl)-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxylic acid (100 mg, 199.81 μmol) in DMF (2 mL) were added DIEA (103.30 mg, 799.24 μmol, 139.21 μL), HOBt (54.00 mg, 399.62 μmol) and EDCI (76.61 mg, 399.62 μmol) at 0° C. The mixture was warmed to 25° C. and stirred for 12 hours.

The mixture was diluted with water (5 mL) and extracted with dichloromethane/methanol (10/1, 5 mL×3). The combined organic phase was washed with brine (5 mL×3), dried over anhydrous Na₂SO₄, filtered and concentrated in vacuo. The residue was purified by preparative HPLC (column: Phenomenex luna C18 150*25 mm*10 um; mobile phase: [water (FA)-ACN]; gradient: 35%-65% B over 10 min) to afford the desired product 8-(3,5-difluoro-2-pyridyl)-N-[8-[5-[(1S)-1-[(2S,4R)-4-hydroxy-2-[[4-(4-methylthiazol-5-yl)phenyl]methylcarbamoyl]pyrrolidine-1-carbonyl]-2-methyl-propyl]isoxazol-3-yl]oxyoctyl]-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxamide (30.23 mg, 26.39 μmol, 13.21% yield, 95.5% purity) as a white solid. ¹H NMR: DMSO-d₆, 400 MHz. δ 11.93 (s, 1H), 8.99 (s, 1H), 8.58-8.37 (m, 2H), 8.12-8.06 (m, 1H), 7.92 (s, 1H), 7.76 (s, 1H), 7.66-7.59 (m, 1H), 7.45-7.39 (m, 3H), 7.37 (s, 1H), 7.29-7.25 (m, 2H), 6.08 (s, 1H), 5.20-5.09 (m, 1H), 4.41-4.31 (m, 4H), 4.14-4.12 (m, 2H), 3.79-3.74 (m, 1H), 3.68-3.61 (m, 5H), 3.47-3.43 (m, 2H), 3.16 (m, 4H), 2.91 (s, 3H), 2.46 (s, 3H), 2.28-2.24 (m, 1H), 2.06-2.01 (m, 1H), 1.93-1.89 (m, 1H), 1.72-1.66 (m, 2H), 1.49-1.43 (m, 2H), 1.34-1.24 (m, 8H), 0.95 (d, J=6.8 Hz, 3H), 0.80 (d, J=6.8 Hz, 3H). LCMS: m/z 1094.7 [M+H]⁺.

### Example C-10. Synthesis of 8-(3,5-difluoro-2-pyridyl)-N-[[4-[4-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethyl]phenyl]phenyl]methyl]-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxamide

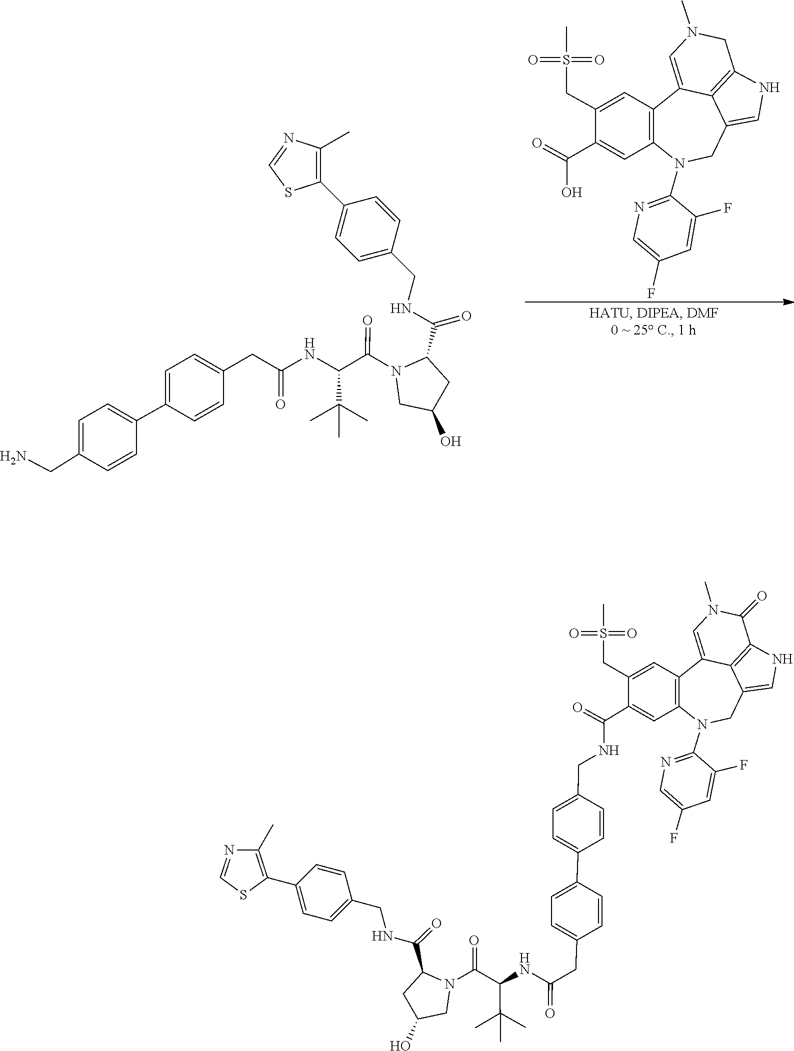 [SMILES: Cc1ncsc1-c1ccc(CNC(=O)[C@@H]2C[C@@H](O)CN2C(=O)[C@@H](NC(=O)Cc2ccc(-c3ccc(CN)cc3)cc2)C(C)(C)C)cc1 ; CN1C=C2c3cc(CS(C)(=O)=O)c(C(=O)O)cc3N(c3ncc(F)cc3F)Cc3c[nH]c(c32)C1 ; Cc1ncsc1-c1ccc(CNC(=O)[C@@H]2C[C@@H](O)CN2C(=O)[C@@H](NC(=O)Cc2ccc(-c3ccc(CNC(=O)c4cc5c(cc4CS(C)(=O)=O)-c4cn(C)c(=O)c6[nH]cc(c46)CN5c4ncc(F)cc4F)cc3)cc2)C(C)(C)C)cc1]

To a mixture of (2S,4R)-1-[(2S)-2-[[2-[4-[4-(aminomethyl)phenyl]phenyl]acetyl]amino]-3,3-dimethyl-butanoyl]-4-hydroxy-N-[[4-(4-methylthiazol-5-yl)phenyl]methyl]pyrrolidine-2-carboxamide (200 mg, 289.73 μmol, HCl salt), DIPEA (224.68 mg, 1.74 mmol, 302.80 μL) and 8-(3,5-difluoro-2-pyridyl)-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxylic acid (140.00 mg, 279.73 μmol) in DMF (2 mL) was added HATU (220.33 mg, 579.46 μmol) at 0° C. The mixture was warmed to 25° C. and stirred for 1 hour under N₂. The reaction mixture was diluted with water (5 mL) and extracted with Dichloromethane/Methanol (10/1, 5 mL×3). The combined organic layer were washed with brine (10 mL×3), dried over anhydrous Na₂SO₄, filtered and concentrated in vacuo. The residue was purified by preparative HPLC (column: Phenomenex luna C18 150*25 mm*10 um; mobile phase: [water (FA)-ACN]; gradient: 37%-57% B over 10 min) to afford the desired product 8-(3,5-difluoro-2-pyridyl)-N-[[4-[4-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethyl]phenyl]phenyl]methyl]-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxamide (49.84 mg, 43.12 μmol, 14.88% yield, 98.3% purity) as a white solid. ¹H NMR: DMSO-d₆, 400 MHz. δ 11.93 (s, 1H), 9.02-8.97 (m, 2H), 8.58 (t, J=6.0 Hz, 1H), 8.17 (d, J=9.6 Hz, 1H), 8.09-8.06 (m, 1H), 7.94 (s, 1H), 7.77 (s, 1H), 7.68-7.61 (m, 1H), 7.58-7.55 (m, 4H), 7.44-7.40 (m, 4H), 7.38-7.33 (m, 5H), 7.29-7.27 (m, 1H), 6.14-4.77 (m, 2H), 4.56-4.54 (m, 1H), 4.47-4.40 (m, 4H), 4.36-4.33 (m, 1H), 4.25-4.19 (m, 1H), 3.75-3.58 (m, 7H), 3.52-3.45 (m, 1H), 2.89 (s, 3H), 2.45-2.42 (m, 5H), 2.07-2.00 (m, 1H), 1.93-1.87 (m, 1H), 0.93 (s, 9H). LCMS: m/z 1136.6 [M+H]⁺.

### Example C-11. Synthesis of 8-(3,5-difluoro-2-pyridyl)-N-[2-[3-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethyl]-3,9-diazaspiro[5.5]undecan-9-yl]ethyl]-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxamide

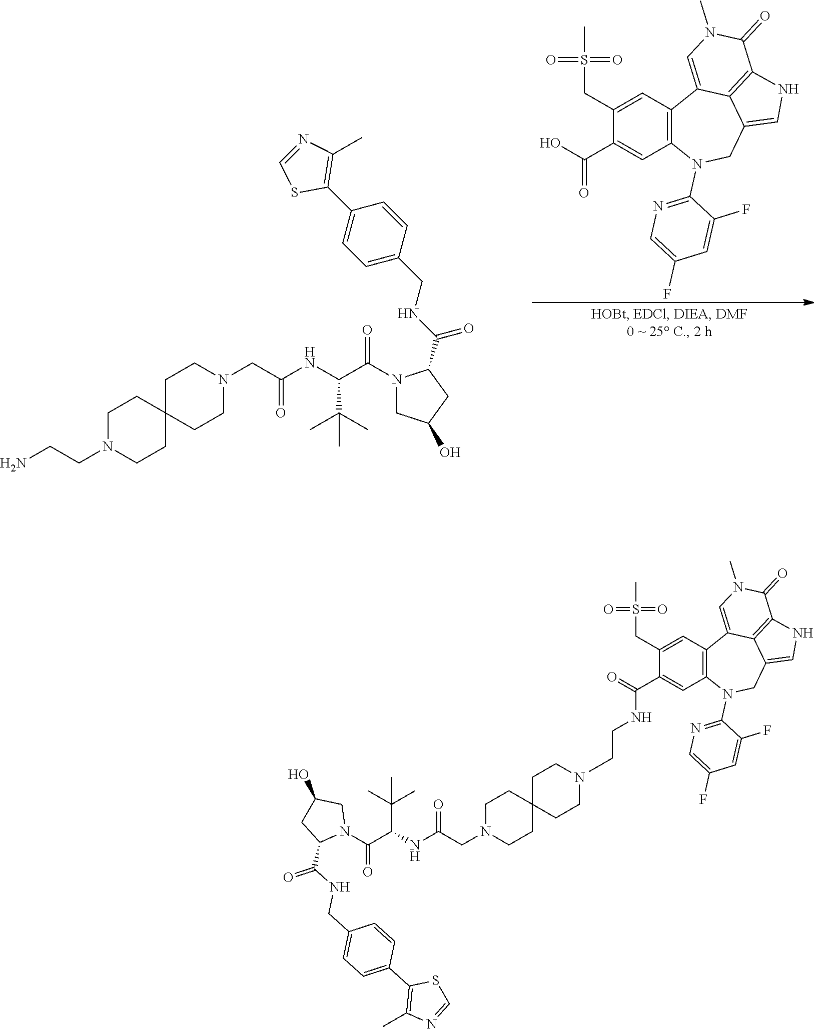

To a mixture of (2S,4R)-1-[(2S)-2-[[2-[9-(2-aminoethyl)-3,9-diazaspiro[5.5]undecan-3-yl]acetyl]amino]-3,3-dimethyl-butanoyl]-4-hydroxy-N-[[4-(4-methylthiazol-5-yl)phenyl]methyl]pyrrolidine-2-carboxamide (170.84 mg, 219.79 μmol, 3HCl salt) and 8-(3,5-difluoro-2-pyridyl)-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxylic acid (100 mg, 199.81 μmol) in DMF (1 mL) were added EDCI (76.61 mg, 399.62 μmol), HOBt (54.00 mg, 399.62 μmol) and DIEA (103.29 mg, 799.24 μmol, 139.21 μL) at 0° C. The mixture was stirred at 25° C. under N₂ for 2 hours. The reaction mixture was diluted with water (1 mL) and extracted with ethyl acetate (2 mL×3). The combined organic phase was washed with brine (1 mL), dried with anhydrous Na₂SO₄, filtered and concentrated in vacuo. The residue was purified by preparative HPLC(column: Phenomenex luna C18 150*25 mm*10 um; mobile phase: [water (FA)-ACN]; gradient: 7%-37% B over 10 min) to afford the desired product 8-(3,5-difluoro-2-pyridyl)-N-[2-[3-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethyl]-3,9-diazaspiro[5.5]undecan-9-yl]ethyl]-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxamide (34.17 mg, 29.20 μmol, 14.61% yield, 98.3% purity) as a yellow solid. ¹H NMR: DMSO-d₆, 400 MHz. δ 11.93 (s, 1H), 8.97 (s, 1H), 8.60 (t, J=6.0 Hz, 1H), 8.34 (t, J=5.6 Hz, 1H), 8.18 (s, 1H), 8.07 (s, 1H), 7.92 (s, 1H), 7.83-7.77 (m, 1H), 7.75 (s, 1H), 7.63-7.61 (m, 1H), 7.44-7.40 (m, 4H), 7.29-7.22 (m, 2H), 6.12-4.92 (m, 2H), 4.51-4.34 (m, 4H), 4.31-4.19 (m, 2H), 3.69-3.56 (m, 7H), 2.91 (s, 3H), 2.44-2.30 (m, 16H), 2.14-1.81 (m, 4H), 1.43-1.34 (m, 6H), 0.94 (s, 9H). LCMS: RT=2.058 min, m/z 1150.8 [M+H]⁺.

### Example C-12. Synthesis of 8-(3,5-difluoro-2-pyridyl)-N-[[1-[6-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-6-oxo-hexyl]-4-piperidyl]methyl]-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxamide

### A. Step 1

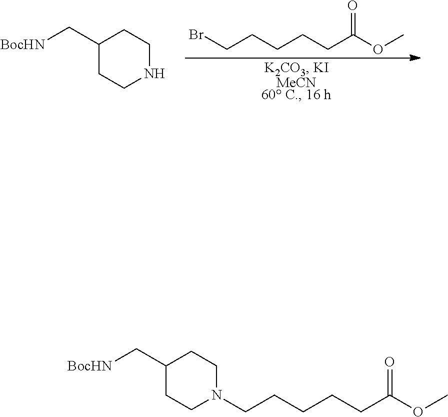

A mixture of tert-butyl N-(4-piperidylmethyl)carbamate (1 g, 4.67 mmol), methyl 6-bromohexanoate (1.46 g, 7.00 mmol), K₂CO3 (1.93 g, 14.00 mmol) and KI (774.61 mg, 4.67 mmol) in ACN (10 mL) was heated to 60° C. and stirred for 16 hours under N₂. The mixture was diluted with water (10 mL) and extracted with dichloromethane/methanol (10/1, 20 mL×3). The combined organic phase was washed with brine (20 mL), dried with anhydrous Na₂SO₄, filtered and concentrated in vacuo. The residue was purified by column chromatography on silica gel (Dichloromethane/Methanol=20/1) to afford the desired product methyl 6-[4-[(tert-butoxycarbonylamino)methyl]-1-piperidyl]hexanoate (900 mg, 2.63 mmol, 56.32% yield) as a yellow solid. ¹H NMR: DMSO-d₆, 400 MHz. δ 7.04-6.86 (m, 1H), 3.59 (s, 3H), 3.53-3.39 (m, 2H), 3.27-3.11 (m, 1H), 3.05-2.94 (m, 2H), 2.92-2.71 (m, 4H), 2.33 (t, J=7.4 Hz, 2H), 1.84-1.71 (m, 2H), 1.63-1.54 (m, 4H), 1.37 (s, 9H), 1.32-1.19 (m, 4H).

### B. Step 2

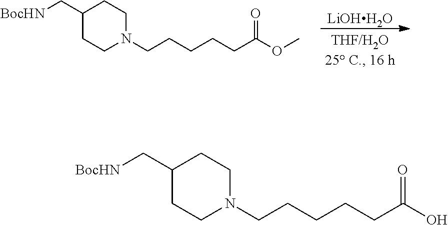

To a solution of methyl 6-[4-[(tert-butoxycarbonylamino)methyl]-1-piperidyl]hexanoate (900 mg, 2.63 mmol) in THF (10 mL) and H₂O (2 mL) was added LiOH H₂O (330.83 mg, 7.88 mmol) at 25° C. The mixture was stirred at 25° C. for 16 hours.

The mixture was concentrated in vacuo. The residue was purified by preparative HPLC (column: YMC Triart C18 70*250 mm*7 um; mobile phase: [water (NH₄HCO₃)-ACN]; gradient: 5%-35% B over 20 min) to afford the desired product 6-[4-[(tert-butoxycarbonylamino)methyl]-1-piperidyl]hexanoic acid (560 mg, 1.71 mmol, 64.88% yield) as a yellow oil. ¹H NMR: DMSO-d₆, 400 MHz. δ 6.95-6.67 (m, 1H), 2.84-2.73 (m, 4H), 2.24-2.12 (m, 4H), 1.83-1.73 (m, 2H), 1.59-1.45 (m, 4H), 1.43-1.34 (m, 11H), 1.32-1.20 (m, 3H), 1.11-0.99 (m, 2H). LCMS: m/z 329.0 [M+H]⁺.

### C. Step 3

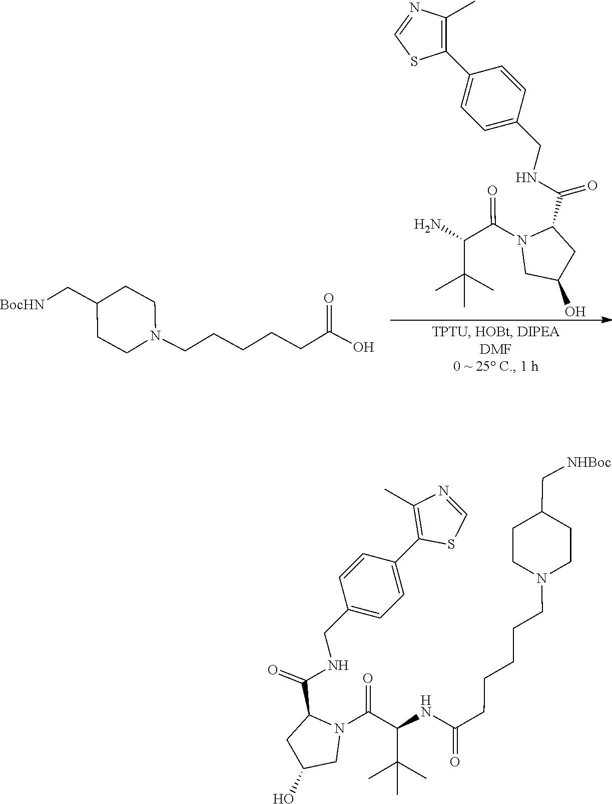 [SMILES: CC(C)(C)OC(=O)NCC1CCN(CCCCCC(=O)O)CC1 ; Cc1ncsc1-c1ccc(CNC(=O)[C@@H]2C[C@@H](O)CN2C(=O)[C@@H](N)C(C)(C)C)cc1 ; Cc1ncsc1-c1ccc(CNC(=O)[C@@H]2C[C@@H](O)CN2C(=O)[C@@H](NC(=O)CCCCCN2CCC(CNC(=O)OC(C)(C)C)CC2)C(C)(C)C)cc1]

To a solution of 6-[4-[(tert-butoxycarbonylamino)methyl]-1-piperidyl]hexanoic acid (150 mg, 456.70 μmol), (2S,4R)-1-[(2S)-2-amino-3,3-dimethyl-butanoyl]-4-hydroxy-N-[[4-(4-methylthiazol-5-yl)phenyl]methyl]pyrrolidine-2-carboxamide (213.29 mg, 456.70 μmol, HCl salt) and DIEA (354.15 mg, 2.74 mmol, 477.29 μL) in DMF (2 mL) were added HOBt (92.57 mg, 685.04 μmol) and TPTU (203.50 mg, 685.04 μmol) at 0° C. under N₂. The mixture was warmed to 25° C. and stirred for 1 hour under N₂. The mixture was diluted with water (5 mL) and extracted with dichloromethane/methanol (10/1, 10 mL×3). The combined organic phase was washed with brine (10 mL), dried with anhydrous Na₂SO₄, filtered and concentrated in vacuo. The residue was purified by preparative HPLC (column: Welch Xtimate C18 150*25 mm*5 um; mobile phase: [water (HCl)-ACN]; gradient: 12%-42% B over 8 min) to afford the desired product tert-butyl N-[[1-[6-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-6-oxo-hexyl]-4-piperidyl]methyl]carbamate (125 mg, crude) as a white solid. ¹H NMR: DMSO-d₆, 400 MHz. δ 8.61-8.50 (m, 1H), 7.90-7.77 (m, 2H), 7.56-7.49 (m, 1H), 7.45-7.33 (m, 4H), 7.31-7.22 (m, 2H), 6.91-6.82 (m, 1H), 4.58-4.34 (m, 4H), 3.71-3.59 (m, 3H), 3.09-3.03 (m, 2H), 2.84-2.77 (m, 2H), 2.44 (s, 3H), 2.28-1.88 (m, 7H), 1.68-1.59 (m, 2H), 1.53-1.43 (m, 4H), 1.37 (s, 9H), 1.26-1.15 (m, 6H), 0.93 (s, 9H).

### D. Step 4

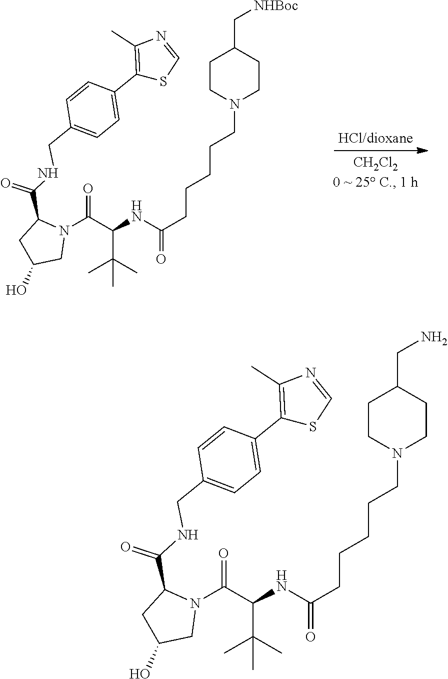 [SMILES: Cc1ncsc1-c1ccc(CNC(=O)[C@@H]2C[C@@H](O)CN2C(=O)[C@@H](NC(=O)CCCCCN2CCC(CNC(=O)OC(C)(C)C)CC2)C(C)(C)C)cc1 ; Cc1ncsc1-c1ccc(CNC(=O)[C@@H]2C[C@@H](O)CN2C(=O)[C@@H](NC(=O)CCCCCN2CCC(CN)CC2)C(C)(C)C)cc1]

To a solution of tert-butyl N-[[1-[6-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-6-oxo-hexyl]-4-piperidyl]methyl]carbamate (125 mg, 168.69 μmol, crude) in CH₂Cl₂ (2 mL) was added HCl/dioxane (4 M in dioxane, 8.0 mmol, 2 mL) at 25° C. The mixture was stirred at 25° C. for 1 hour. The mixture was concentrated in vacuo to afford (2S,4R)-1-[(2S)-2-[6-[4-(aminomethyl)-1-piperidyl]hexanoylamino]-3,3-dimethyl-butanoyl]-4-hydroxy-N-[[4-(4-methylthiazol-5-yl)phenyl]methyl]pyrrolidine-2-carboxamide (120 mg, 163.07 mol, 96.67% yield, 97% purity, 2HCl salt) as a white solid. LCMS: m/z 641.4 [M+H].

### E. Step 5

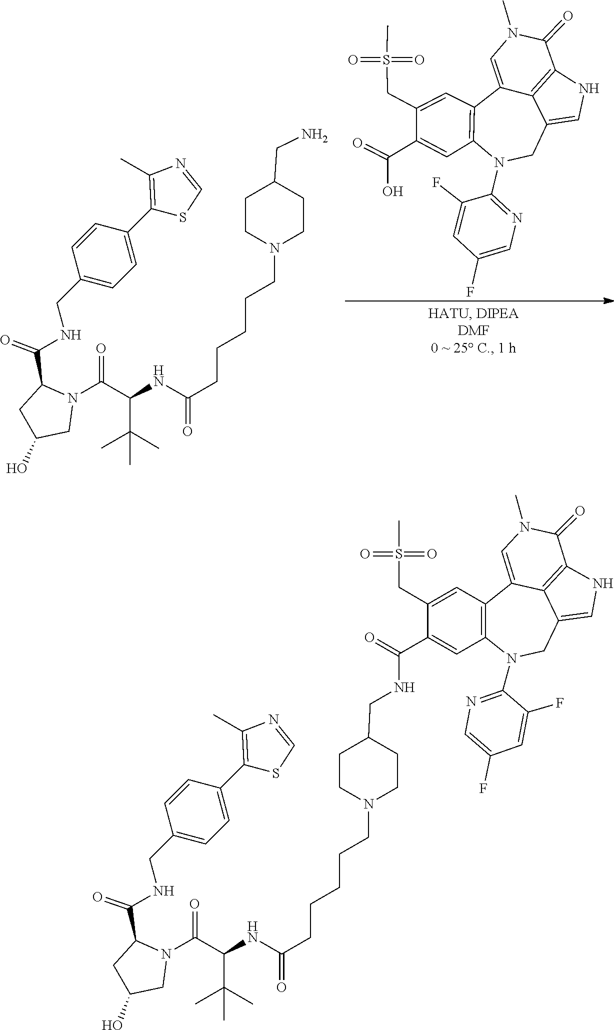 [SMILES: Cc1ncsc1-c1ccc(CNC(=O)[C@@H]2C[C@@H](O)CN2C(=O)[C@@H](NC(=O)CCCCCN2CCC(CN)CC2)C(C)(C)C)cc1 ; Cn1cc2c3c(c[nH]c3c1=O)CN(c1ncc(F)cc1F)c1cc(C(=O)O)c(CS(C)(=O)=O)cc1-2 ; Cc1ncsc1-c1ccc(CNC(=O)[C@@H]2C[C@@H](O)CN2C(=O)[C@@H](NC(=O)CCCCCN2CCC(CNC(=O)c3cc4c(cc3CS(C)(=O)=O)-c3cn(C)c(=O)c5[nH]cc(c35)CN4c3ncc(F)cc3F)CC2)C(C)(C)C)cc1]

To a solution of (2S,4R)-1-[(2S)-2-[6-[4-(aminomethyl)-1-piperidyl]hexanoylamino]-3,3-dimethyl-butanoyl]-4-hydroxy-N-[[4-(4-methylthiazol-5-yl)phenyl]methyl]pyrrolidine-2-carboxamide (95 mg, 133.09 μmol, 2HCl salt), 8-(3,5-difluoro-2-pyridyl)-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxylic acid (66.61 mg, 133.09 μmol) and DIEA (103.21 mg, 798.54 μmol, 139.09 μL) in DMF (1 mL) was added HATU (50.61 mg, 133.09 μmol) at 0° C. under N₂. The mixture was warmed to 25° C. and stirred for 1 hour under N₂. The mixture was diluted with water (5 mL) and extracted with ethyl acetate (10 mL×3). The combined organic phase was washed with brine (10 mL), dried with anhydrous Na₂SO₄, filtered and concentrated in vacuo. The residue was purified by preparative HPLC (column: Phenomenex luna C18 150*25 mm*10 um; mobile phase: [water (FA)-ACN]; gradient: 11%-41% B over 10 min) to afford 8-(3,5-difluoro-2-pyridyl)-N-[[1-[6-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-6-oxo-hexyl]-4-piperidyl]methyl]-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxamide (46.18 mg, 40.29 μmol, 30.27% yield, 98% purity) as a white solid. ¹H NMR: DMSO-d₆, 400 MHz. δ 11.92 (s, 1H), 8.98 (s, 1H), 8.60-8.52 (m, 1H), 8.49-8.40 (m, 1H), 8.22-8.17 (m, 1H), 8.11-8.03 (m, 1H), 7.95-7.88 (m, 1H), 7.86-7.81 (m, 1H), 7.78-7.72 (m, 1H), 7.65-7.57 (m, 1H), 7.43-7.36 (m, 4H), 7.30-7.25 (m, 2H), 6.07-5.73 (m, 1H), 5.27-5.06 (m, 1H), 4.56-4.52 (m, 1H), 4.46-4.39 (m, 2H), 4.37-4.33 (m, 1H), 4.24-4.18 (m, 1H), 3.71-3.64 (m, 4H), 3.62 (s, 3H), 3.07-3.02 (m, 2H), 2.93-2.88 (m, 5H), 2.44 (s, 3H), 2.37-2.31 (m, 2H), 2.28-2.21 (m, 1H), 2.15-1.88 (m, 6H), 1.68-1.60 (m, 2H), 1.52-1.42 (m, 4H), 1.25-1.11 (m, 4H), 0.93 (s, 9H). LCMS: m/z 1123.7 [M+H]⁺.

### Example C-13. Synthesis of 8-(3,5-difluoro-2-pyridyl)-N-[5-[4-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethyl]piperazin-1-yl]pentyl]-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxamide

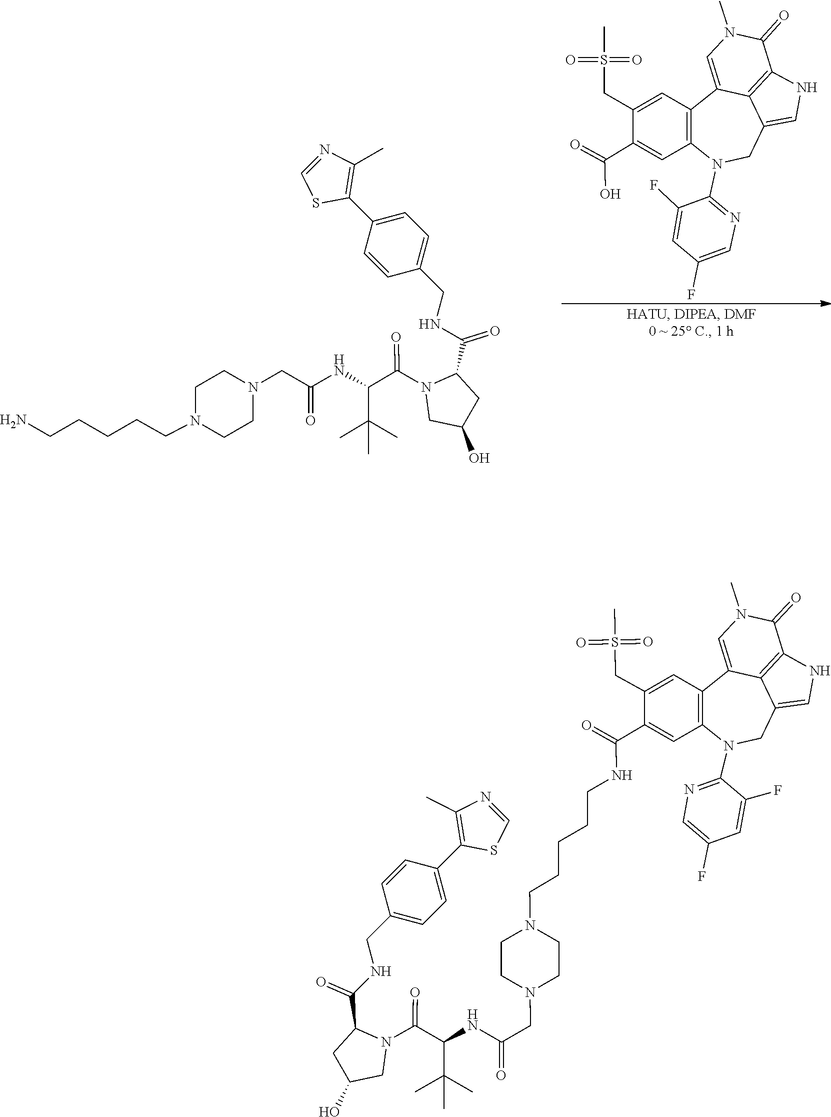 [SMILES: Cc1ncsc1-c1ccc(CNC(=O)[C@@H]2C[C@@H](O)CN2C(=O)[C@@H](NC(=O)CN2CCN(CCCCCN)CC2)C(C)(C)C)cc1 ; Cn1cc2c3c(c[nH]c3c1=O)CN(c1ncc(F)cc1F)c1cc(C(=O)O)c(CS(C)(=O)=O)cc1-2 ; Cc1ncsc1-c1ccc(CNC(=O)[C@@H]2C[C@@H](O)CN2C(=O)[C@@H](NC(=O)CN2CCN(CCCCCNC(=O)c3cc4c(cc3CS(C)(=O)=O)-c3cn(C)c(=O)c5[nH]cc(c35)CN4c3ncc(F)cc3F)CC2)C(C)(C)C)cc1]

To a solution of (2S,4R)-1-[(2S)-2-[[2-[4-(5-aminopentyl)piperazin-1-yl]acetyl]amino]-3,3-dimethyl-butanoyl]-4-hydroxy-N-[[4-(4-methylthiazol-5-yl)phenyl]methyl]pyrrolidine-2-carboxamide (120.09 mg, 159.85 μmol, 3HCl salt) and 8-(3,5-difluoro-2-pyridyl)-15-methyl-4-(methylsulfonylmethyl)-14-oxo-8,12,15-tri azatetracyclo[8.6.1.02,7.013,17]heptadeca-1(16),2(7),3,5,10,13(17)-hexaene-5-carboxylic acid (80 mg, 159.85 μmol) in DMF (1 mL) were added DIEA (123.95 mg, 959.09 μmol, 167.05 μL) and HATU (60.78 mg, 159.85 μmol) at 0° C. The mixture was stirred at 25° C. for 0.5 hour. The reaction mixture was diluted with water (2 mL) and extracted with Dichloromethane/Methanol (10/1, 5 mL×3). The combined phase was washed with brine (10 mL×3), dried over anhydrous Na₂SO₄, filtered and concentrated in vacuo. The residue was purified by preparative HPLC (column: Phenomenex luna C18 150*25 mm*10 um; mobile phase: [water (FA)-ACN]; gradient: 16%-36% B over 10 min) to afford the desired product 8-(3,5-difluoro-2-pyridyl)-N-[5-[4-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethyl]piperazin-1-yl]pentyl]-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxamide (42.08 mg, 37.02 μmol, 23.16% yield, 98.9% purity) as a white solid. ¹H NMR: DMSO-d₆, 400 MHz. δ 11.93 (s, 1H), 8.96 (s, 1H), 8.60-8.58 (m, 1H), 8.42-8.40 (m, 1H), 8.14 (s, 1H), 8.09-8.04 (m, 1H), 7.91 (s, 1H), 7.82-7.74 (m, 2H), 7.64-7.57 (m, 1H), 7.41-7.38 (m, 3H), 7.29-7.26 (m, 2H), 6.12-5.78 (m, 1H), 5.16-5.13 (m, 2H), 4.55-4.19 (m, 8H), 3.68-3.48 (m, 8H), 3.19-2.97 (m, 6H), 2.91 (s, 3H), 2.43 (s, 3H), 2.38-2.29 (m, 2H), 2.09-2.00 (m, 1H), 1.95-1.83 (m, 1H), 1.51-1.38 (m, 5H), 1.32-1.18 (m, 3H), 0.94 (s, 9H). LCMS: m/z 1124.5 [M+H]⁺.

### Example C-14. Synthesis of (2S,4R)-1-[(2R)-2-acetamido-3-[2-[4-[2-[[2-[(9S)-7-(4-chlorophenyl)-4,5,13-trimethyl-3-thia-1,8,11,12-tetrazatricyclo[8.3.0.02,6]trideca-2(6),4,7,10,12-pentaen-9-yl]acetyl]amino]ethyl]piperazin-1-yl]ethylsulfanyl]-3-methyl-butanoyl]-4-hydroxy-n-[[4-(4-methylthiazol-5-yl)phenyl]methyl]pyrrolidine-2-carboxamide

### A. Step 1

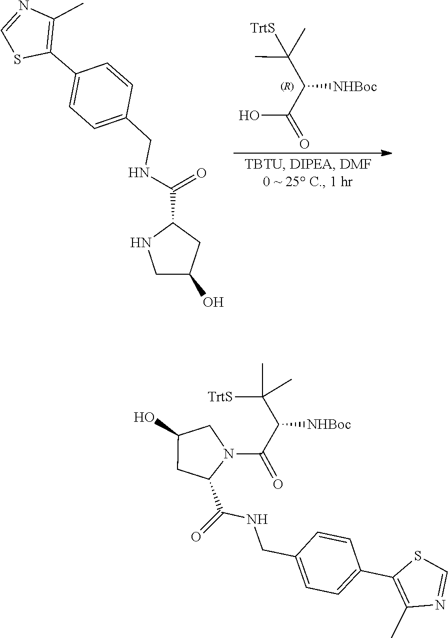

To a mixture of (2R)-2-(tert-butoxycarbonylamino)-3-methyl-3-tritylsulfanyl-butanoic acid (3.06 g, 6.22 mmol), (2S,4R)-4-hydroxy-N-[[4-(4-methylthiazol-5-yl)phenyl]methyl]pyrrolidine-2-carboxamide (2 g, 5.65 mmol, HCl salt) and DIPEA (2.92 g, 22.61 mmol, 3.94 mL) in DMF (20 mL) was added TBTU (2.72 g, 8.48 mmol) at 0° C. The mixture was stirred at 25° C. for 2 hours under N₂. The reaction mixture was diluted with water (20 mL). The mixture was extracted with Dichloromethane/Methanol (10/1, 25 mL×3). The combined organic phase was washed with brine (30 mL), dried with anhydrous Na₂SO₄, filtered and concentrated in vacuo. The residue was purified by column chromatography on silica gel (Petroleum ether/Ethyl acetate=0/1) to afford the desired product tert-butyl N-[(1R)-1-[(2S,4R)-4-hydroxy-2-[[4-(4-methylthiazol-5-yl)phenyl]methylcarbamoyl]pyrrolidine-1-carbonyl]-2-methyl-2-tritylsulfanylpropyl]carbamate (3.2 g, 4.05 mmol, 71.58% yield). ¹H NMR: DMSO-d₆, 400 MHz. δ 8.99 (s, 1H), 8.49-8.39 (m, 1H), 7.51-7.47 (m, 6H), 7.33-7.25 (m, 10H), 7.21-7.16 (m, 3H), 6.84-6.76 (m, 1H), 4.36-4.18 (m, 4H), 3.52-3.36 (m, 4H), 2.41 (s, 3H), 2.02-1.95 (m, 2H), 1.88-1.80 (m, 1H), 1.41 (s, 9H), 1.03 (s, 3H), 0.86 (s, 3H).

### B. Step 2

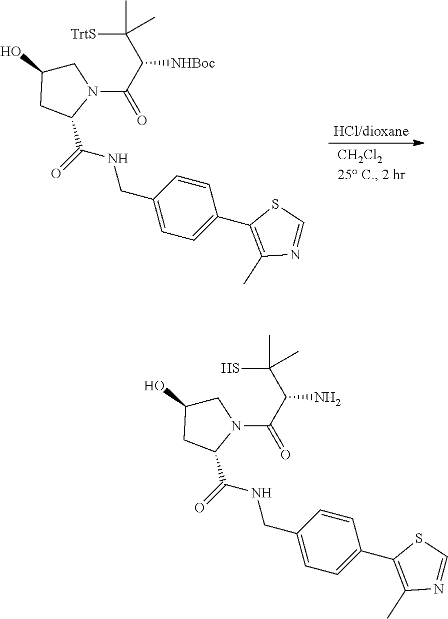

To a solution of tert-butyl N-[(1R)-1-[(2S, 4R)-4-hydroxy-2-[[4-(4-methylthiazol-5-yl)phenyl]methylcarbamoyl]pyrrolidine-1-carbonyl]-2-methyl-2-tritylsulfanyl-propyl]carbamate (3.2 g, 4.05 mmol) in CH₂Cl₂ (30 mL) was added HCl/dioxane (2 M in dioxane, 30 mmol, 15.0 mL) at 25° C. The mixture was stirred at 25° C. for 2 hours under N₂. The reaction mixture was concentrated in vacuo to afford the desired product (2S, 4R)-1-[(2R)-2-amino-3-methyl-3-sulfanyl-butanoyl]-4-hydroxy-N-[[4-(4-methylthiazol-5-yl)phenyl]methyl]pyrrolidine-2-carboxamide (1.9 g, 3.92 mmol, 96.83% yield, HCl salt) as a white solid. ¹H NMR: DMSO-d₆, 400 MHz. δ 9.03 (s, 1H), 8.86-8.73 (m, 1H), 8.42-8.33 (m, 2H), 7.41-7.33 (m, 4H), 4.58-4.52 (m, 1H), 4.47-4.39 (m, 4H), 4.27-4.22 (m, 2H), 3.84-3.67 (m, 2H), 2.45 (s, 3H), 2.17-1.86 (m, 2H), 1.51 (s, 3H), 1.37 (s, 3H).

### C. Step 3

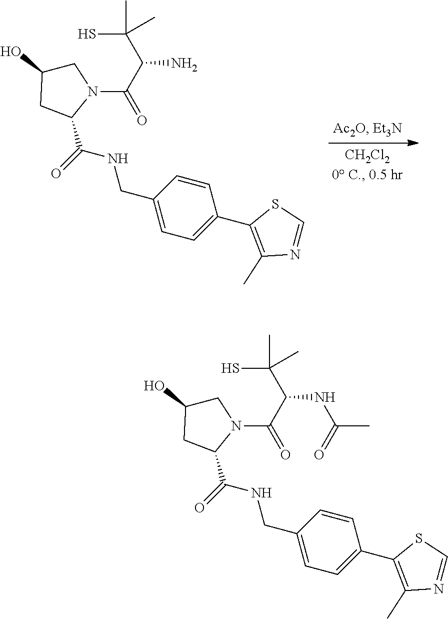 [SMILES: Cc1ncsc1-c1ccc(CNC(=O)[C@@H]2C[C@@H](O)CN2C(=O)[C@@H](N)C(C)(C)S)cc1 ; CC(=O)N[C@H](C(=O)N1C[C@H](O)C[C@H]1C(=O)NCc1ccc(-c2scnc2C)cc1)C(C)(C)S]

To a mixture of (2S, 4R)-1-[(2R)-2-amino-3-methyl-3-sulfanyl-butanoyl]-4-hydroxy-N-[[4-(4-methylthiazol-5-yl)phenyl]methyl]pyrrolidine-2-carboxamide (1.9 g, 3.92 mmol, HCl salt) and Et3N (792.73 mg, 7.83 mmol, 1.09 mL) in CH₂Cl₂ (20 mL) was added Ac₂O (399.89 mg, 3.92 mmol, 367.88 uL,) at 0° C. The mixture was stirred at 0° C. for 0.5 hour. The reaction mixture was diluted with water (20 mL). The mixture was extracted with Dichloromethane (25 mL×3). The combined organic phase was washed with brine (30 mL), dried with anhydrous Na₂SO₄, filtered and concentrated in vacuo. The residue was purified by column chromatography on silica gel (Dichloromethane/Methanol=20/1) to afford the desired product (2S,4R)-1-[(2R)-2-acetamido-3-methyl-3-sulfanyl-butanoyl]-4-hydroxy-N-[[4-(4-methylthiazol-5-yl)phenyl]methyl]pyrrolidine-2-carboxamide (1.55 g, 3.16 mmol, 80.65% yield). ¹H NMR: DMSO-d₆, 400 MHz. δ 8.98 (s, 1H), 8.61 (t, J=6.0 Hz, 1H), 8.13 (d, J=9.6 Hz, 1H), 7.44-7.37 (m, 4H), 5.28-5.08 (m, 1H), 4.84 (d, J=9.6 Hz, 1H), 4.48-4.33 (m, 3H), 4.29-4.24 (m, 1H), 3.91-3.83 (m, 1H), 3.67-3.61 (m, 1H), 2.44 (s, 3H), 2.14-1.93 (m, 2H), 1.91 (s, 3H), 1.38 (s, 3H), 1.28 (s, 3H).

### D. Step 4

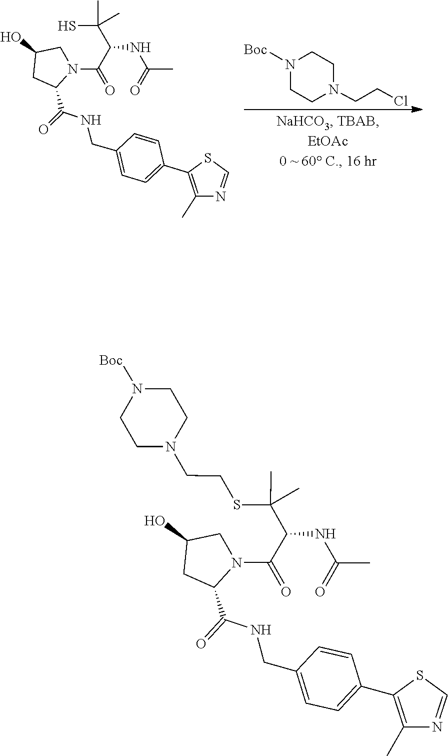 [SMILES: CC(=O)N[C@H](C(=O)N1C[C@H](O)C[C@H]1C(=O)NCc1ccc(-c2scnc2C)cc1)C(C)(C)S ; CC(C)(C)OC(=O)N1CCN(CCCl)CC1 ; CC(=O)N[C@H](C(=O)N1C[C@H](O)C[C@H]1C(=O)NCc1ccc(-c2scnc2C)cc1)C(C)(C)SCCN1CCN(C(=O)OC(C)(C)C)CC1]

To a mixture of (2S,4R)-1-[(2R)-2-acetamido-3-methyl-3-sulfanyl-butanoyl]-4-hydroxy-N-[[4-(4-methylthiazol-5-yl)phenyl]methyl]pyrrolidine-2-carboxamide (400 mg, 815.27 μmol), tert-butyl 4-(2-chloroethyl)piperazine-1-carboxylate (243.36 mg, 978.32 μmol) and TBAB (1.05 g, 3.26 mmol) in EtOAc (5 mL) was added saturated aqueous NaHCO₃ solution (2.16 g, 25.70 mmol, 1.00 mL) at 0° C. The mixture was heated to 60° C. and stirred for 16 hours. The reaction mixture was diluted with water (5 mL). The mixture was extracted with Dichloromethane/Methanol (10/1, 8 mL×3). The combined organic phase was washed with brine (10 mL), dried with anhydrous Na₂SO₄, filtered and concentrated in vacuo. The residue was purified by column chromatography on silica gel (Dichloromethane/Methanol=20/1) to afford the desired product tert-butyl 4-[2-[(2R)-2-acetamido-3-[(2S,4R)-4-hydroxy-2-[[4-(4-methylthiazol-5-yl)phenyl]methylcarbamoyl]pyrrolidin-1-yl]-1,1-dimethyl-3-oxo-propyl]sulfanylethyl]piperazine-1-carboxylate (550 mg, 782.44 μmol, 95.97% yield) as a white solid. ¹H NMR: DMSO-d₆, 400 MHz. δ 8.98 (s, 1H), 8.51-8.44 (m, 1H), 8.18-8.10 (m, 1H), 7.42-7.38 (m, 4H), 5.18-5.13 (m, 1H), 4.87-4.80 (m, 1H), 4.51-4.36 (m, 3H), 4.27-4.19 (m, 1H), 3.77-3.64 (m, 2H), 3.26-3.21 (m, 4H), 3.19-3.13 (m, 1H), 2.67-2.58 (m, 2H), 2.44 (s, 3H), 2.41-2.35 (m, 2H), 2.29-2.26 (m, 2H), 2.08-1.92 (m, 2H), 1.89 (s, 3H), 1.39-1.37 (m, 12H), 1.28 (s, 3H).

### E. Step 5

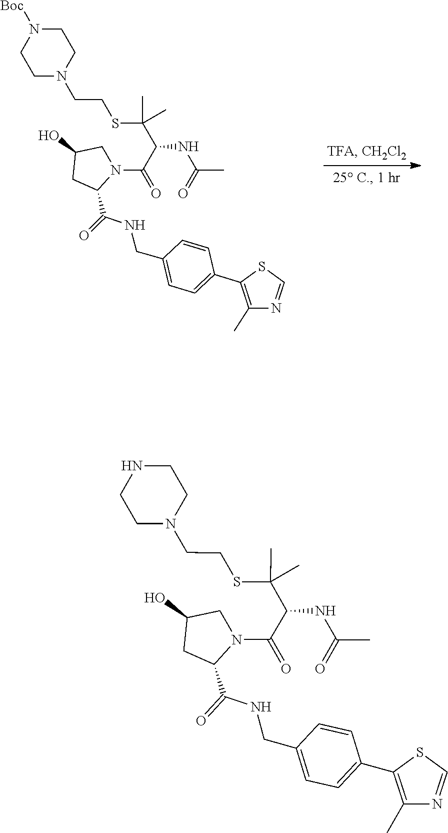 [SMILES: CC(=O)N[C@H](C(=O)N1C[C@H](O)C[C@H]1C(=O)NCc1ccc(-c2scnc2C)cc1)C(C)(C)SCCN1CCN(C(=O)OC(C)(C)C)CC1 ; CC(=O)N[C@H](C(=O)N1C[C@H](O)C[C@H]1C(=O)NCc1ccc(-c2scnc2C)cc1)C(C)(C)SCCN1CCNCC1]

To a solution of tert-butyl 4-[2-[(2R)-2-acetamido-3-[(2S,4R)-4-hydroxy-2-[[4-(4-methylthiazol-5-yl)phenyl]methylcarbamoyl]pyrrolidin-1-yl]-1,1-dimethyl-3-oxo-propyl]sulfanylethyl]piperazine-1-carboxylate (550 mg, 782.44 μmol) in CH₂Cl₂ (6 mL) was added TFA (89.22 mg, 782.44 μmol, 58.12 uL) at 25° C. and stirred for 1 hour under N₂. The reaction mixture was concentrated in vacuo to afford the desired product (2S,4R)-1-[(2R)-2-acetamido-3-methyl-3-(2-piperazin-1-ylethylsulfanyl)butanoyl]-4-hydroxy-N-[[4-(4-methylthiazol-5-yl)phenyl]methyl]pyrrolidine-2-carboxamide (620 mg, 746.22 μmol, 95.37% yield, 2TFA salt) as a yellow oil. ¹H NMR: DMSO-d₆, 400 MHz. δ 9.17 (brs, 1H), 9.00 (s, 1H), 8.67-8.59 (m, 1H), 8.33-8.26 (m, 1H), 7.43-7.39 (m, 4H), 4.89-4.80 (m, 1H), 4.47-4.21 (m, 5H), 3.78-3.63 (m, 2H), 3.34-3.08 (m, 6H), 2.89-2.81 (m, 2H), 2.45 (s, 3H), 2.30-1.99 (m, 2H), 1.92 (s, 3H), 1.90-1.86 (m, 1H), 1.60-1.53 (m, 1H), 1.47-1.41 (m, 3H), 1.33 (s, 3H), 1.31-1.20 (m, 2H).

### F. Step 6

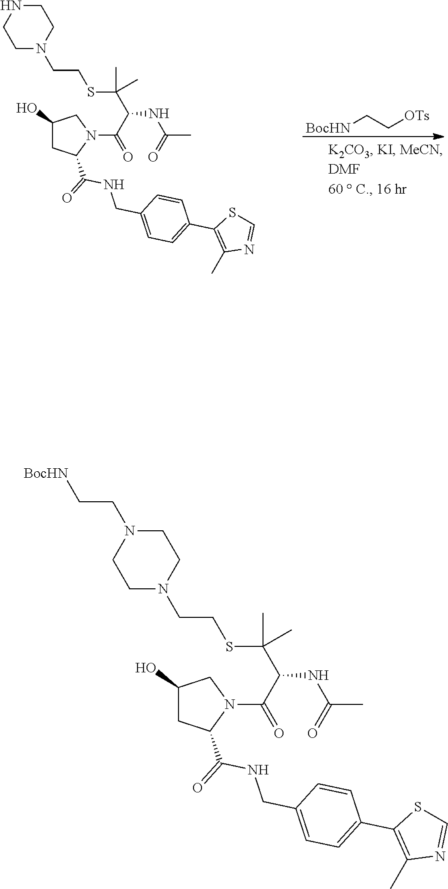 [SMILES: CC(=O)N[C@H](C(=O)N1C[C@H](O)C[C@H]1C(=O)NCc1ccc(-c2scnc2C)cc1)C(C)(C)SCCN1CCNCC1 ; Cc1ccc(S(=O)(=O)OCCNC(=O)OC(C)(C)C)cc1 ; CC(=O)N[C@H](C(=O)N1C[C@H](O)C[C@H]1C(=O)NCc1ccc(-c2scnc2C)cc1)C(C)(C)SCCN1CCN(CCNC(=O)OC(C)(C)C)CC1]

A mixture of (2S,4R)-1-[(2R)-2-acetamido-3-methyl-3-(2-piperazin-1-ylethylsulfanyl)butanoyl]-4-hydroxy-N-[[4-(4-methylthiazol-5-yl)phenyl]methyl]pyrrolidine-2-carboxamide (620 mg, 746.22 μmol, 2TFA salt), 2-(tertbutoxycarbonylamino)ethyl 4-methylbenzenesulfonate (282.41 mg, 895.46 μmol), K₂CO₃ (309.40 mg, 2.24 mmol) and KI (123.87 mg, 746.22 μmol) in DMF (6 mL) was heated to 60° C. and stirred for 16 hours under N₂. The reaction mixture was diluted with water (5 mL). The mixture was extracted with Dichloromethane/Methanol (10/1, 6 mL×3). The combined organic phase was washed with brine (8 mL), dried with anhydrous Na₂SO₄, filtered and concentrated in vacuo. The residue was purified by column chromatography on silica gel (Dichloromethane/Methanol=10/1) to afford the desired product tert-butyl N-[2-[4-[2-[(2R)-2-acetamido-3-[(2S,4R)-4-hydroxy-2-[[4-(4-methylthiazol-5-yl)phenyl]methylcarbamoyl]pyrrolidin-1-yl]-1,1-dimethyl-3-oxopropyl]sulfanylethyl]piperazin-1-yl]ethyl]carbamate (300 mg, crude) as a colorless oil. LCMS: m/z 746.3 [M+H]⁺.

### G. Step 7

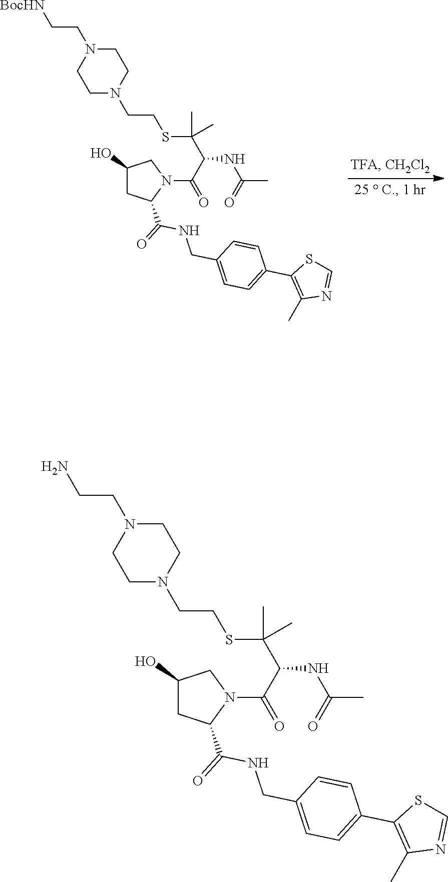 [SMILES: CC(=O)N[C@H](C(=O)N1C[C@H](O)C[C@H]1C(=O)NCc1ccc(-c2scnc2C)cc1)C(C)(C)SCCN1CCN(CCNC(=O)OC(C)(C)C)CC1 ; CC(=O)N[C@H](C(=O)N1C[C@H](O)C[C@H]1C(=O)NCc1ccc(-c2scnc2C)cc1)C(C)(C)SCCN1CCN(CCN)CC1]

To a solution of tert-butyl N-[2-[4-[2-[(2R)-2-acetamido-3-[(2S,4R)-4-hydroxy-2-[[4-(4-methylthiazol-5-yl)phenyl]methylcarbamoyl]pyrrolidin-1-yl]-1,1-dimethyl-3-oxo-propyl]sulfanylethyl]piperazin-1-yl]ethyl]carbamate (300 mg, 402.15 μmol) in CH₂Cl₂ (3 mL) was added TFA (1.54 g, 13.46 mmol, 1 mL) at 25° C. The mixture was stirred at 25° C. for 1 hour under N₂. The reaction mixture was concentrated in vacuo to afford the desired product (2S,4R)-1-[(2R)-2-acetamido-3-[2-[4-(2-aminoethyl)piperazin-1-yl]ethylsulfanyl]-3-methyl-butanoyl]-4-hydroxy-N-[[4-(4-methylthiazol-5-yl)phenyl]methyl]pyrrolidine-2-carboxamide (390 mg, crude, 3TFA salt) as a yellow oil. LCMS: m/z 646.3 [M+H]⁺.

### H. Step 8

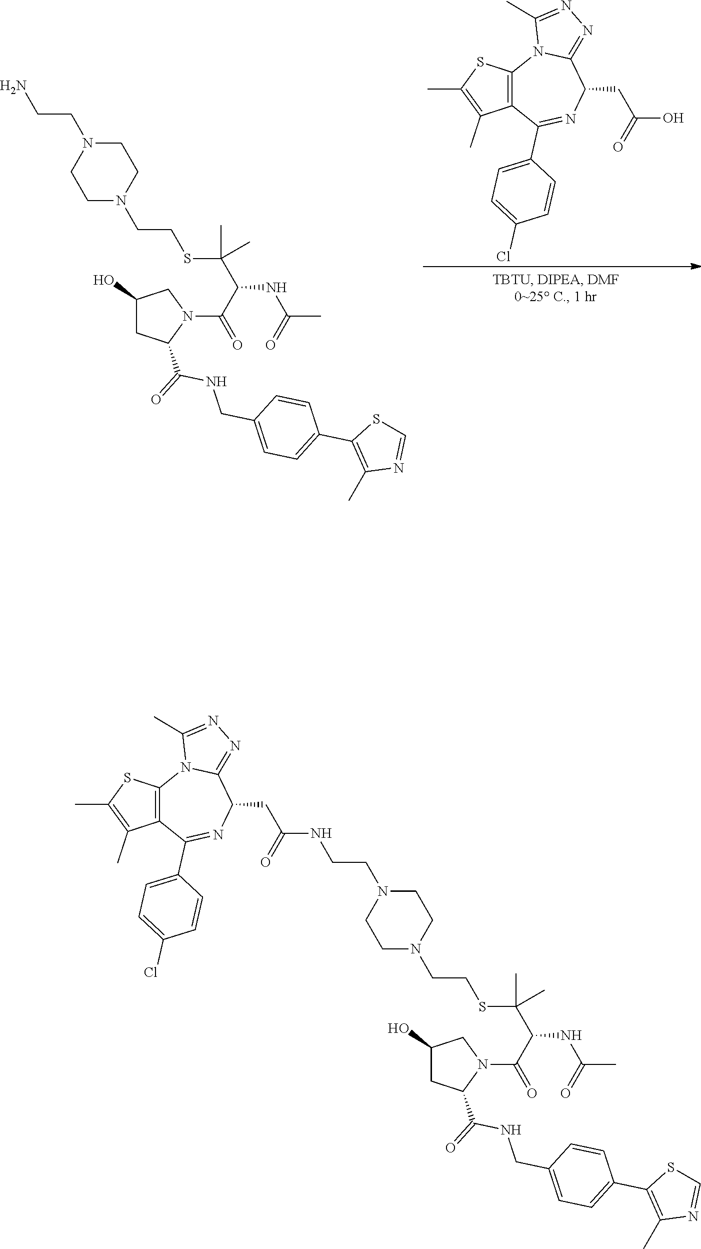 [SMILES: CC(=O)N[C@H](C(=O)N1C[C@H](O)C[C@H]1C(=O)NCc1ccc(-c2scnc2C)cc1)C(C)(C)SCCN1CCN(CCN)CC1 ; Cc1sc2c(c1C)C(c1ccc(Cl)cc1)=N[C@@H](CC(=O)O)c1nnc(C)n1-2 ; CC(=O)N[C@H](C(=O)N1C[C@H](O)C[C@H]1C(=O)NCc1ccc(-c2scnc2C)cc1)C(C)(C)SCCN1CCN(CCNC(=O)C[C@@H]2N=C(c3ccc(Cl)cc3)c3c(sc(C)c3C)-n3c(C)nnc32)CC1]

To a mixture of (2S,4R)-1-[(2R)-2-acetamido-3-[2-[4-(2-aminoethyl)piperazin-1-yl]ethylsulfanyl]-3-methylbutanoyl]-4-hydroxy-N-[[4-(4-methylthiazol-5-yl)phenyl]methyl]pyrrolidine-2-carboxamide (15 mg, 19.86 μmol, 3HCl salt), 2-[(9S)-7-(4-chlorophenyl)-4,5,13-trimethyl-3-thia-1,8,11,12-tetrazatricyclo[8.3.0.02,6]trideca-2(6),4,7,10,12-pentaen-9-yl]acetic acid (7.96 mg, 19.86 μmol) and DIPEA (10.27 mg, 79.44 μmol, 13.84 uL) in DMF (0.5 mL) was added TBTU (9.57 mg, 29.79 μmol) at 0° C. The mixture was stirred at 25° C. for 1 hour under N₂. The reaction mixture was diluted with water (1 mL) and extracted with Dichloromethane/Methanol (10/1, 2 mL×3). The combined organic phase was washed with brine (3 mL), dried with anhydrous Na₂SO₄, filtered and concentrated in vacuo. The residue was purified by preparative HPLC (column: Phenomenex luna C18150*25 mm*10 um; mobile phase: [water (FA)-ACN]; gradient: 20%-50% B over 8 min) to afford the desired product (2S,4R)-1-[(2R)-2-acetamido-3-[2-[4-[2-[[2-[(9S)-7-(4-chlorophenyl)-4,5,13-trimethyl-3-thia-1,8,11,12-tetrazatricyclo[8.3.0.02,6]trideca-2(6),4,7,10,12-pentaen-9-yl]acetyl]amino]ethyl]piperazin-1-yl]ethylsulfanyl]-3-methyl-butanoyl]-4-hydroxy-N-[[4-(4-methylthiazol-5-yl)phenyl]methyl]pyrrolidine-2-carboxamide (3.79 mg, 3.60 μmol, 18.15% yield, 97.847% purity) as a white solid. ¹H NMR: DMSO-d₆, 400 MHz. δ 8.99 (s, 1H), 8.53-8.37 (m, 1H), 8.16-8.09 (m, 2H), 7.50-7.46 (m, 2H), 7.44-7.38 (m, 6H), 5.24-5.05 (m, 1H), 4.90-4.76 (m, 1H), 4.52-4.33 (m, 4H), 4.29-4.20 (m, 1H), 3.78-3.63 (m, 2H), 3.26-3.14 (m, 6H), 2.59 (s, 3H), 2.46-2.43 (m, 4H), 2.41 (s, 3H), 2.37-2.32 (m, 8H), 2.06-1.94 (m, 2H), 1.89 (s, 3H), 1.62 (s, 3H), 1.37 (s, 3H), 1.32-1.20 (m, 6H). LCMS: m/z 1028.6 [M+H]⁺.

### Example C-15. Synthesis of (2S,4R)-1-[(2R)-2-acetamido-3-[2-[4-[2-[[2-[(9S)-7-(4-chlorophenyl)-4,5,13-trimethyl-3-thia-1,8,11,12-tetrazatricyclo[8.3.0.02,6]trideca-2(6),4,7,10,12-pentaen-9-yl]acetyl]amino]ethyl]phenyl]ethylsulfanyl]-3-methyl-butanoyl]-4-hydroxy-n-[[4-(4-methylthiazol-5-yl)phenyl]methyl]pyrrolidine-2-carboxamide

### A. Step 1

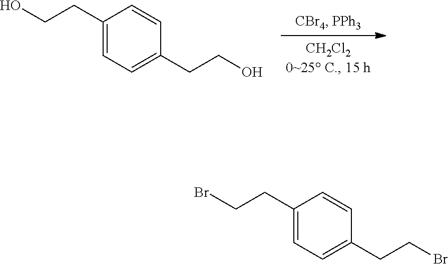 [SMILES: OCCc1ccc(CCO)cc1 ; BrCCc1ccc(CCBr)cc1]

To a solution of 2-[4-(2-hydroxyethyl)phenyl]ethanol (2.8 g, 16.85 mmol) and CBr₄ (16.76 g, 50.54 mmol) in CH₂Cl₂ (30 mL) was added PPh₃ (13.25 g, 50.54 mmol) at 0° C. under N₂. Then the mixture was stirred at 25° C. for 15 hours. The reaction mixture was diluted with water (50 mL) and extracted with Dichloromethane (50 mL×3). The combined organic phase was dried with anhydrous Na₂SO₄, filtered and concentrated in vacuo. The residue was purified by column chromatography on silica gel (Petroleum ether/Ethyl acetate=15/1) to afford the desired product 1,4-bis(2-bromoethyl)benzene (4.6 g, 15.75 mmol, 93.51% yield) as a white solid. ¹H NMR: CDCl₃, 400 MHz. δ 7.20-7.16 (m, 4H), 3.57 (t, J=7.2 Hz, 4H), 3.16 (t, J=8.0 Hz, 4H).

### B. Step 2

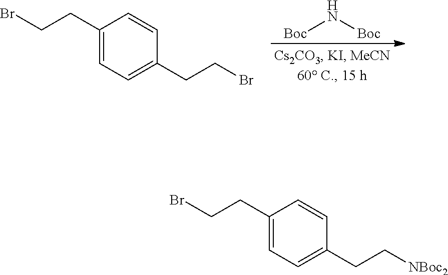

To a solution of 1,4-bis(2-bromoethyl)benzene (4.60 g, 15.74 mmol) and tert-butyl N-tert-butoxycarbonylcarbamate (2.28 g, 10.49 mmol) in ACN (50 mL) were added Cs₂CO₃ (6.84 g, 20.99 mmol) and KI (174.21 mg, 1.05 mmol) under N₂. The mixture was heated to 60° C. and stirred for 15 hours. The reaction mixture was diluted with water (50 mL) and extracted with Ethyl acetate (50 mL×3). The combined organic phase was dried with anhydrous Na₂SO₄, filtered and concentrated in vacuo. The residue was purified by column chromatography on silica gel (Petroleum ether/Ethyl acetate=15/1) to afford the desired product tert-butyl N-[2-[4-(2-bromoethyl)phenyl]ethyl]-N-tert-butoxycarbonyl-carbamate (1.66 g, 3.86 mmol, 36.82% yield) as a yellow oil. ¹H NMR: CDCl₃, 400 MHz. δ 7.18-7.14 (m, 4H), 3.80-3.77 (m, 2H), 3.55 (t, J=7.6 Hz, 2H), 3.17-3.11 (m, 2H), 2.88-2.84 (m, 2H), 1.50 (s, 18H).

### C. Step 3

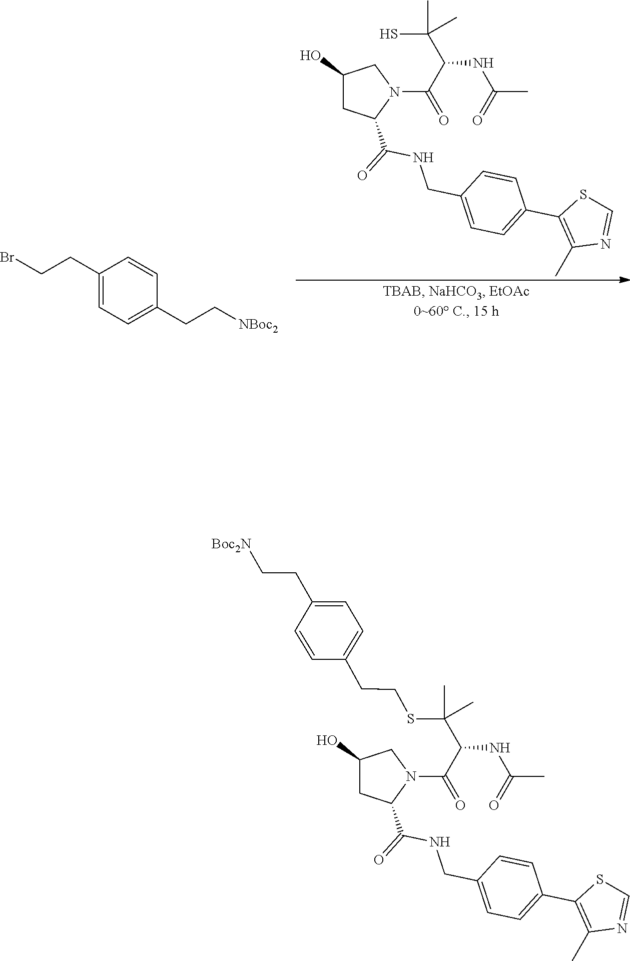

To a mixture of (2S,4R)-1-[(2R)-2-acetamido-3-methyl-3-sulfanyl-butanoyl]-4-hydroxy-N-[[4-(4-methylthiazol-5-yl)phenyl]methyl]pyrrolidine-2-carboxamide (50 mg, 101.91 mol), tert-butyl N-[2-[4-(2-bromoethyl)phenyl]ethyl]-N-tert-butoxycarbonyl-carbamate (52.38 mg, 122.29 μmol) and TBAB (131.41 mg, 407.63 μmol) in EtOAc (1 mL) was added saturated NaHCO₃ solution (302.00 mg, 3.59 mmol, 0.2 mL) at 0° C. The mixture was stirred at 60° C. for 15 hours. The reaction mixture was diluted with water (5 mL) and extracted with Ethyl acetate (5 mL×3). The combined organic phase was dried with anhydrous Na₂SO₄, filtered and concentrated in vacuo. The residue was purified by preparative TLC on silica gel (Dichloromethane/Methanol=20/1) to afford the desired product tert-butyl N-[2-[4-[2-[(2R)-2-acetamido-3-[(2S,4R)-4-hydroxy-2-[[4-(4-methylthiazol-5-yl)phenyl]methylcarbamoyl]pyrrolidin-1-yl]-1,1-dimethyl-3-oxo-propyl]sulfanylethyl]phenyl]ethyl]-N-tertbutoxycarbonyl-carbamate (40 mg, 47.73 μmol, 46.83% yield) as a yellow oil. LCMS: m/z 838.3 [M+H]⁺.

### D. Step 4

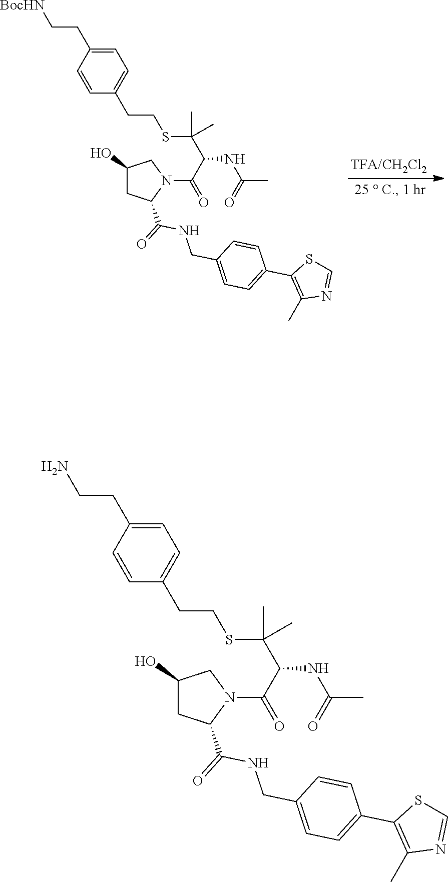 [SMILES: CC(=O)N[C@H](C(=O)N1C[C@H](O)C[C@H]1C(=O)NCc1ccc(-c2scnc2C)cc1)C(C)(C)SCCc1ccc(CCNC(=O)OC(C)(C)C)cc1 ; CC(=O)N[C@H](C(=O)N1C[C@H](O)C[C@H]1C(=O)NCc1ccc(-c2scnc2C)cc1)C(C)(C)SCCc1ccc(CCN)cc1]

To a solution of tert-butyl N-[2-[4-[2-[(2R)-2-acetamido-3-[(2S,4R)-4-hydroxy-2-[[4-(4-methylthiazol-5-yl)phenyl]methylcarbamoyl]pyrrolidin-1-yl]-1,1-dimethyl-3-oxo-propyl]sulfanylethyl]phenyl]ethyl]-N-tertbutoxycarbonyl-carbamate (40 mg, 47.73 μmol) in CH₂Cl₂ (0.5 mL) was added TFA (153.50 mg, 1.35 mmol, 0.1 mL) under N₂. Then the mixture was stirred at 25° C. for 1 hour. The mixture was concentrated in vacuo to afford the desired product (2S,4R)-1-[(2R)-2-acetamido-3-[2-[4-(2-aminoethyl)phenyl]ethylsulfanyl]-3-methyl-butanoyl]-4-hydroxy-N-[[4-(4-methylthiazol-5-yl)phenyl]methyl]pyrrolidine-2-carboxamide (40 mg, 53.20 μmol, 98.15% yield, TFA salt) as a yellow oil. LCMS: m/z 638.3 [M+H]⁺.

### E. Step 5

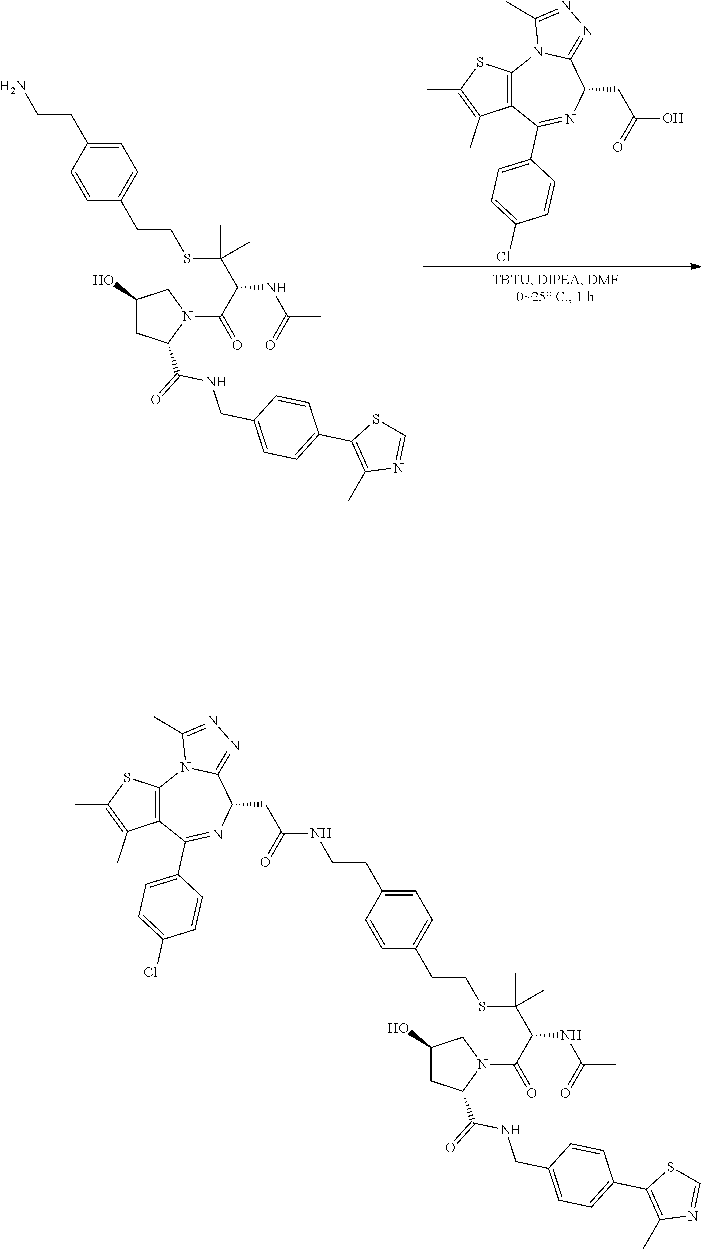 [SMILES: CC(=O)N[C@H](C(=O)N1C[C@H](O)C[C@H]1C(=O)NCc1ccc(-c2scnc2C)cc1)C(C)(C)SCCc1ccc(CCN)cc1 ; Cc1sc2c(c1C)C(c1ccc(Cl)cc1)=N[C@@H](CC(=O)O)c1nnc(C)n1-2 ; CC(=O)N[C@H](C(=O)N1C[C@H](O)C[C@H]1C(=O)NCc1ccc(-c2scnc2C)cc1)C(C)(C)SCCc1ccc(CCNC(=O)C[C@@H]2N=C(c3ccc(Cl)cc3)c3c(sc(C)c3C)-n3c(C)nnc32)cc1]

To a solution of (2S,4R)-1-[(2R)-2-acetamido-3-[2-[4-(2-aminoethyl)phenyl]ethylsulfanyl]-3-methyl-butanoyl]-4-hydroxy-N-[[4-(4-methylthiazol-5-yl)phenyl]methyl]pyrrolidine-2-carboxamide (40 mg, 53.20 μmol, TFA salt) and 2-[(9S)-7-(4-chlorophenyl)-4,5,13-trimethyl-3-thia-1,8,11,12-tetrazatricyclo[8.3.0.02,6]trideca-2(6),4,7,10,12-pentaen-9-yl]acetic acid (21.33 mg, 53.20 μmol) in DMF (1 mL) were added DIEA (34.38 mg, 266.00 μmol, 46.33 μL) and TBTU (34.16 mg, 106.40 μmol) at 0° C. under N₂. The mixture was stirred at 25° C. for 1 hour. The reaction mixture was diluted with water (5 mL) and extracted with Ethyl acetate (5 mL×3). The combined organic phase was dried with anhydrous Na₂SO₄, filtered and concentrated in vacuo. The residue was purified by preparative HPLC (column: Phenomenex luna C18 150*25 mm*10 um; mobile phase: [water (FA)-ACN]; gradient: 35%-65% B over 8 min) to afford the desired product (2S,4R)-1-[(2R)-2-acetamido-3-[2-[4-[2-[[2-[(9S)-7-(4-chlorophenyl)-4,5,13-trimethyl-3-thia-1,8,11,12-tetrazatricyclo[8.3.0.02,6]trideca-2(6),4,7,10,12-pentaen-9-yl]acetyl]amino]ethyl]phenyl]ethylsulfanyl]-3-methyl-butanoyl]-4-hydroxy-N-[[4-(4-methylthiazol-5-yl)phenyl]methyl]pyrrolidine-2-carboxamide (23.43 mg, 22.01 μmol, 41.38% yield, 95.9% purity) as a white solid. ¹H NMR: DMSO-d₆, 400 MHz. δ 8.97 (s, 1H), 8.42 (t, J=5.6 Hz, 1H), 8.29 (t, J=5.2 Hz, 1H), 8.16-8.13 (m), 7.49-7.46 (m, 2H), 7.42-7.38 (m, 6H), 7.12 (s, 4H), 5.14 (d, J=3.6 Hz, 11H), 4.86 (d, J=9.6 Hz, 1H), 4.51 (t, J=6.8 Hz, 1H), 4.43-4.33 (m, 3H), 4.27-4.20 (m, 1H), 3.73-3.64 (m, 2H), 3.24-3.21 (m, 2H), 2.83-2.61 (m, 8H), 2.59 (s, 3H), 2.43 (s, 3H), 2.41 (s, 3H), 2.09-1.92 (m, 2H), 1.89 (s, 3H), 1.62 (s, 3H), 1.38 (s, 3H), 1.28 (s, 3H). LCMS: m/z 1020.6 [M+H]⁺.

### Example C-16. Synthesis of 8-(3,5-difluoro-2-pyridyl)-N-[2-[3-[3-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethoxy]propoxy]propoxy]ethyl]-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxamide

### A. Step 1

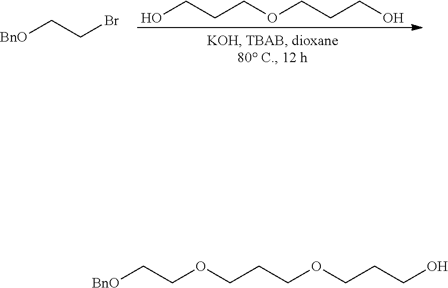 [SMILES: OCCCOCCCO ; BrCCOCc1ccccc1 ; OCCCOCCCOCCOCc1ccccc1]

To a solution of 2-bromoethoxymethylbenzene (10 g, 46.49 mmol, 7.35 mL) and 3-(3-hydroxypropoxy)propan-1-ol (12.48 g, 92.99 mmol) in dioxane (100 mL) were added KOH (13.04 g, 232.46 mmol) and TBAB (7.49 g, 23.25 mmol) at 25° C. The mixture was heated to 80° C. and stirred for 12 hours. The reaction mixture was diluted with water (100 mL) and extracted with ethyl acetate (100 mL×3). The organic phase was washed with brine (150 mL), dried over anhydrous Na₂SO₄, filtered and concentrated in vacuo. The residue was purified by column chromatography on silica gel (Petroleum ether/Ethyl acetate=5/1) to afford 3-[3-(2-benzyloxyethoxy)propoxy]propan-1-ol (7 g, 26.09 mmol, 56.11% yield) as a yellow oil. ¹H NMR: CDCl₃, 400 MHz. δ 7.40-7.29 (m, 5H), 4.60 (s, 2H), 3.72-3.64 (m, 4H), 3.54-3.49 (m, 4H), 3.37-3.30 (m, 3H), 1.17-1.09 (m, 6H). LCMS: m/z 269.2 [M+H]⁺.

### B. Step 2

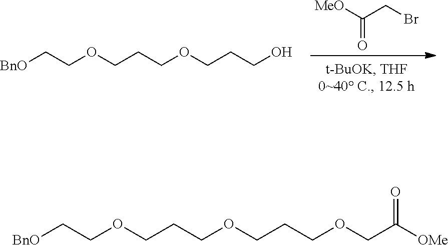 [SMILES: COC(=O)CBr ; OCCCOCCCOCCOCc1ccccc1 ; COC(=O)COCCCOCCCOCCOCc1ccccc1]

To a solution of 3-[3-(2-benzyloxyethoxy)propoxy]propan-1-ol (6.9 g, 25.71 mmol) in THF (50 mL) was added t-BuOK (1 M in THF, 51.43 mmol, 51.43 mL) at 0° C. under N₂. The mixture was stirred at 40° C. for 0.5 hour. To the mixture was added methyl 2-bromoacetate (11.80 g, 77.14 mmol, 7.30 mL) at 0° C. under N₂. The mixture was stirred at 25° C. for 12 hours under N₂. The reaction mixture was diluted with water (50 mL) and extracted with ethyl acetate (50 mL×3). The organic phase was washed with brine (50 mL), dried over anhydrous Na₂SO₄, filtered and concentrated in vacuo. The residue was purified by preparative HPLC (column: Phenomenex luna C18 (250*70 mm*10 um); mobile phase: [water (FA)-ACN]; gradient: 30%-70% B over 10 min) to afford methyl 2-[3-[3-(2-benzyloxyethoxy)propoxy]propoxy]acetate (1.6 g, 4.70 mmol, 18.28% yield) as a brown oil. ¹H NMR: CDCl₃, 400 MHz. δ 7.38-7.29 (m, 5H), 4.58 (s, 2H), 4.30-4.19 (m, 2H), 3.75-3.39 (m, 13H), 1.23-1.12 (m, 6H). LCMS: m/z 363.2 [M+Na]⁺.

### C. Step 3

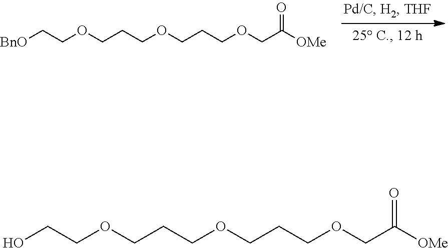 [SMILES: COC(=O)COCCCOCCCOCCOCc1ccccc1 ; COC(=O)COCCCOCCCOCCO]

To a solution of methyl 2-[3-[3-(2-benzyloxyethoxy)propoxy]propoxy](1.6 g, 4.70 mmol) in THE (10 mL) was added Pd/C (800 mg, 751.74 μmol, 10% purity) under N₂. The mixture was degassed and recharged with H₂ for 3 times. The mixture was stirred at 25° C. for 12 hours under H₂ (45 Psi). The reaction mixture was filtered and the filtrate was concentrated in vacuo to afford methyl 2-[3-[3-(2-hydroxyethoxy)propoxy]propoxy]acetate (1.16 g, 4.63 mmol, 98.61% yield) as a light brown oil. ¹H NMR: CDCl₃, 400 MHz. δ 4.32-4.19 (m, 2H), 3.78-3.44 (m, 14H), 1.23-1.12 (m, 6H).

### D. Step 4

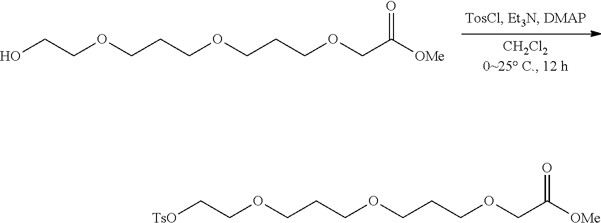 [SMILES: COC(=O)COCCCOCCCOCCO ; COC(=O)COCCCOCCCOCCOS(=O)(=O)c1ccc(C)cc1]

To a solution of methyl 2-[3-[3-(2-hydroxyethoxy)propoxy]propoxy]acetate (2.15 g, 8.59 mmol), Et3N (4.35 g, 42.95 mmol, 5.98 mL) and DMAP (524.71 mg, 4.30 mmol) in CH₂Cl₂ (15 mL) was added TosCl (4.91 g, 25.77 mmol) at 0° C. The mixture was stirred at 25° C. for 12 hours. The reaction mixture was diluted with water (15 mL) and extracted with dichloromethane (15 mL×3). The combined organic phase was washed with brine (30 mL), dried over anhydrous Na₂SO₄, filtered and concentrated in vacuo. The residue was purified by column chromatography on silica gel (Petroleum ether/Ethyl acetate=3/1) to afford methyl 2-[3-[3-[2-(p-tolylsulfonyloxy)ethoxy]propoxy]propoxy]acetate (2.06 g, 5.09 mmol, 59.29% yield) as a brown oil. ¹H NMR: CDCl₃, 400 MHz. δ 7.81 (d, J=8.4 Hz, 2H), 7.35 (d, J=8.0 Hz, 2H), 4.26-4.11 (m, 4H), 3.76-3.68 (m, 5H), 3.60-3.34 (m, 6H), 2.46 (s, 3H), 1.21-1.15 (m, 3H), 1.11-1.06 (m, 3H). LCMS: m/z 427.1 [M+Na]⁺.

### E. Step 5

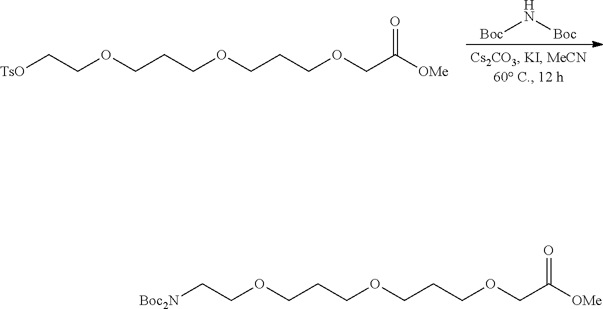

To a solution of methyl 2-[3-[3-[2-(p-tolylsulfonyloxy)ethoxy]propoxy]propoxy]acetate (2.01 g, 4.97 mmol) and tert-butyl N-tert-butoxycarbonylcarbamate (2.16 g, 9.94 mmol) in MeCN (15 mL) were added Cs₂CO₃ (3.24 g, 9.94 mmol) and KI (412.47 mg, 2.48 mmol) at 25° C. The mixture was heated to 60° C. and stirred for 12 hours. The reaction mixture was diluted with water (15 mL) and extracted with ethyl acetate (15 mL×3). The combined organic phase was washed with brine (30 mL), dried over anhydrous Na₂SO₄, filtered and concentrated in vacuo. The residue was purified by column chromatography on silica gel (Petroleum ether/Ethyl acetate=9/1) to afford methyl 2-[3-[3-[2-[bis(tert-butoxycarbonyl)amino]ethoxy]propoxy]propoxy]acetate (1.71 g, 3.80 mmol, 76.55% yield) as a brown oil. ¹H NMR: CDCl₃, 400 MHz. (4.30-4.17 (m, 2H), 3.80-3.71 (m, 5H), 3.65-3.30 (m, 8H), 1.51 (s, 18H), 1.23-1.10 (m, 6H). LCMS: m/z 472.2 [M+Na]⁺.

### F. Step 6

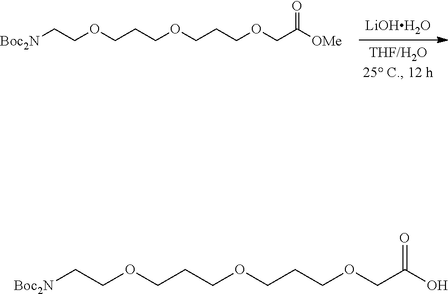

To a solution of methyl 2-[3-[3-[2-[bis(tert-butoxycarbonyl)amino]ethoxy]propoxy]propoxy]acetate (1.71 g, 3.80 mmol) in THE (12 mL) and H₂O (6 mL) was added LiOH·H₂O (798.13 mg, 19.02 mmol). The mixture was stirred at 25° C. for 12 hours. The pH of the reaction mixture was adjusted to 7 by addition of 12 M aqueous HCl solution. The mixture was concentrated in vacuo. The residue was purified by preparative HPLC (column: Daisogel C18 250*70 mm*10 um; mobile phase: [water (NH₄HCO₃)-ACN]; gradient: 10%-40% B over 22 min) to afford 2-[3-[3-[2-[bis(tert-butoxycarbonyl)amino]ethoxy]propoxy]propoxy]acetic acid (960 mg, 2.20 mmol, 57.95% yield) as a white oil. ¹H NMR: CDCl₃, 400 MHz. δ 4.35-4.20 (m, 2H), 4.07-3.93 (m, 2H), 3.81-3.75 (m, 2H), 3.68-3.58 (m, 4H), 3.51-3.46 (m, 2H), 1.51 (s, 18H), 1.22-1.11 (m, 6H). LCMS: m/z 458.1 [M+Na]⁺.

### G. Step 7

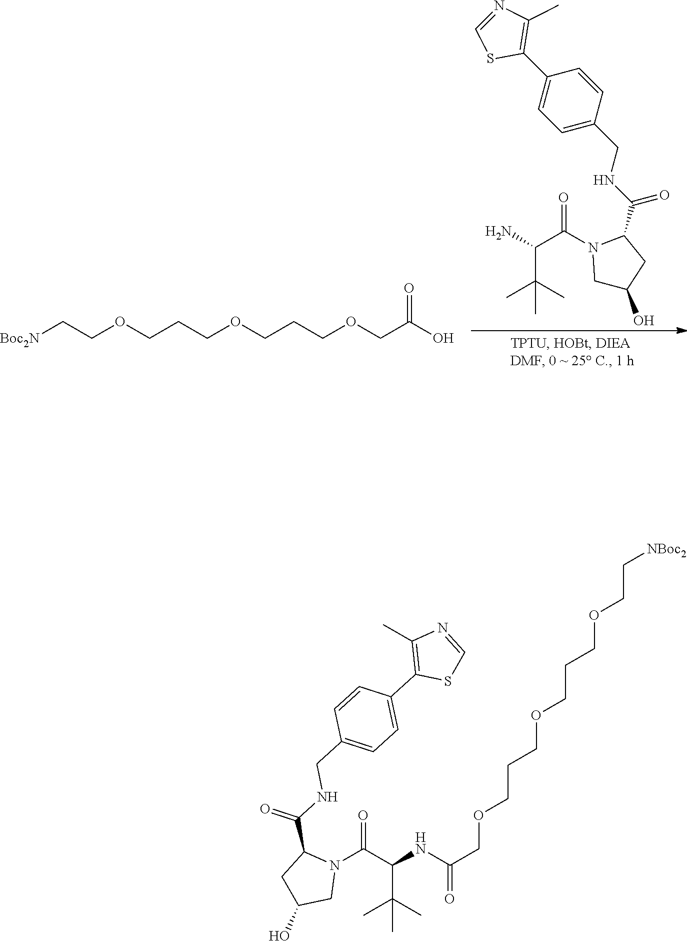

To a solution of 2-[3-[3-[2-[bis(tert-butoxycarbonyl)amino]ethoxy]propoxy]propoxy]acetic acid (242.45 mg, 556.72 μmol), (2S,4R)-1-[(2S)-2-amino-3,3-dimethyl-butanoyl]-4-hydroxy-N-[[4-(4-methylthiazol-5-yl)phenyl]methyl]pyrrolidine-2-carboxamide (200 mg, 428.24 μmol, HCl salt) and DIEA (276.74 mg, 2.14 mmol, 372.96 μL) in DMF (1 mL) were added TPTU (254.43 mg, 856.49 mol) and HOBt (115.73 mg, 856.49 μmol, 2 eq) at 0° C. The mixture was stirred at 25° C. for 1 hour. The reaction mixture was diluted with water (5 mL) and extracted with ethyl acetate (5 mL×3). The combined organic phase was washed with brine (5 mL), dried over anhydrous Na₂SO₄, filtered and concentrated in vacuo. The residue was purified by preparative TLC on silica gel (Dichloromethane/Methanol=10/1) to afford tert-butyl N-tert-butoxycarbonyl-N-[2-[3-[3-[2-[[(1R)-1-[(2R,4S)-4-hydroxy-2-[[4-(4-methylthiazol-5-yl)phenyl]methylcarbamoyl]pyrrolidine-1-carbonyl]-2,2-dimethyl-propyl]amino]-2-oxo-ethoxy]propoxy]propoxy]ethyl]carbamate (195 mg, 229.94 μmol, 53.69% yield) as a yellow oil. LCMS: m/z 870.4 [M+Na]⁺.

### H. Step 8

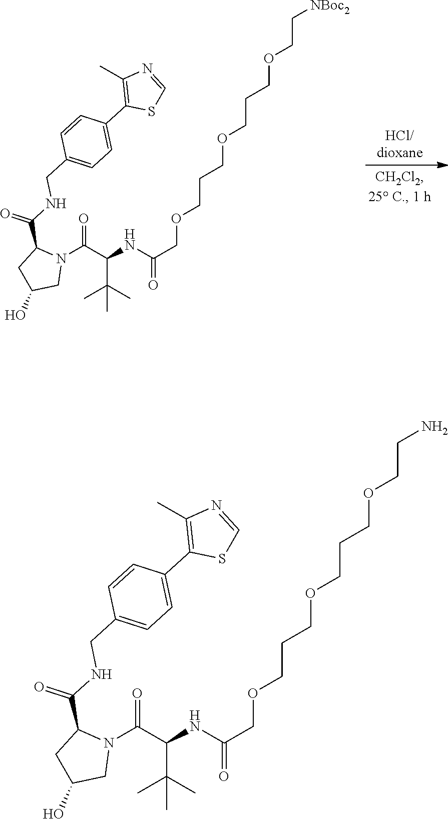

To a solution of tert-butyl N-tert-butoxycarbonyl-N-[2-[3-[3-[2-[[(1R)-1-[(2R,4S)-4-hydroxy-2-[[4-(4-methylthiazol-5-yl)phenyl]methylcarbamoyl]pyrrolidine-1-carbonyl]-2,2-dimethyl-propyl]amino]-2-oxo-ethoxy]propoxy]propoxy]ethyl]carbamate (195 mg, 229.94 μmol) in CH₂Cl₂ (2 mL) was added HCl/dioxane (2 M in dioxane, 8.0 mmol, 4.0 mL). The mixture was stirred at 25° C. for 1 hour. The reaction mixture was concentrated in vacuo to afford (2R,4S)-1-[(2R)-2-[[2-[3-[3-(2-aminoethoxy)propoxy]propoxy]acetyl]amino]-3,3-dimethyl-butanoyl]-4-hydroxy-N-[[4-(4-methylthiazol-5-yl)phenyl]methyl]pyrrolidine-2-carboxamide (160 mg, crude, HCl salt) as a yellow oil. LCMS: m/z 648.3 [M+H]⁺.

### I. I. Step 9

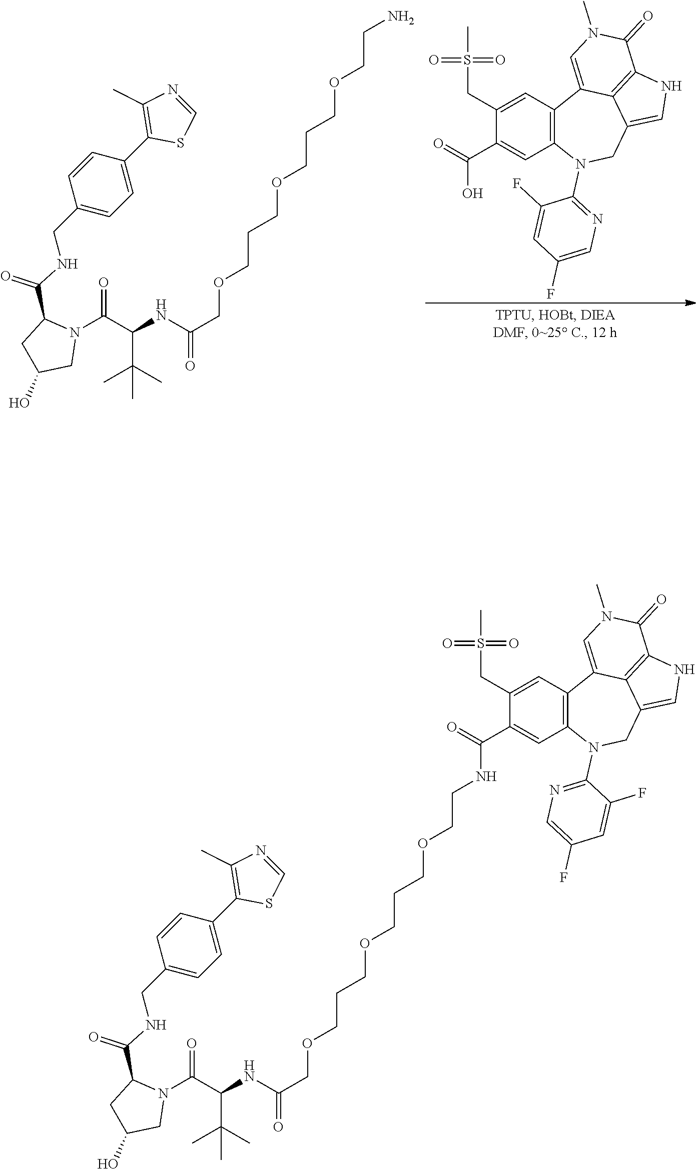 [SMILES: Cc1ncsc1-c1ccc(CNC(=O)[C@@H]2C[C@@H](O)CN2C(=O)[C@@H](NC(=O)COCCCOCCCOCCN)C(C)(C)C)cc1 ; Cn1cc2c3c(c[nH]c3c1=O)CN(c1ncc(F)cc1F)c1cc(C(=O)O)c(CS(C)(=O)=O)cc1-2 ; Cc1ncsc1-c1ccc(CNC(=O)[C@@H]2C[C@@H](O)CN2C(=O)[C@@H](NC(=O)COCCCOCCCOCCNC(=O)c2cc3c(cc2CS(C)(=O)=O)-c2cn(C)c(=O)c4[nH]cc(c24)CN3c2ncc(F)cc2F)C(C)(C)C)cc1]

To a solution of (2R,4S)-1-[(2R)-2-[[2-[3-[3-(2-aminoethoxy)propoxy]propoxy]acetyl]amino]-3,3-dimethyl-butanoyl]-4-hydroxy-N-[[4-(4-methylthiazol-5-yl)phenyl]methyl]pyrrolidine-2-carboxamide (145 mg, 211.90 μmol, HCl salt), 8-(3,5-difluoro-2-pyridyl)-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxylic acid (100 mg, 199.81 μmol) and DIEA (154.94 mg, 1.20 mmol, 208.82 μL) in DMF (2 mL) were added HOBt (54.00 mg, 399.62 μmol) and TPTU (118.71 mg, 399.62 μmol) at 0° C. The mixture was stirred at 25° C. for 12 hours. The reaction mixture was diluted with water (5 mL) and extracted with Dichloromethane/Methanol (10/1, 3 mL×3). The organic phase was washed with brine (5 mL), dried over anhydrous Na₂SO₄, filtered and concentrated in vacuo. The residue was purified by prep-HPLC (column: Waters xbridge 150*25 mm*10 um; mobile phase: [water (NH₄HCO₃)-ACN]; gradient: 25%-55% B over 10 min) to afford 8-(3,5-difluoro-2-pyridyl)-N-[2-[3-[3-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethoxy]propoxy]propoxy]ethyl]-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxamide (22.27 mg, 18.23 μmol, 9.12% yield, 92.5% purity) as a yellow solid. ¹H NMR: DMSO-d₆, 400 MHz. δ 11.91 (s, 1H), 8.96 (s, 1H), 8.70-8.32 (m, 2H), 8.06-7.91 (m, 2H), 7.74 (s, 1H), 7.59-7.57 (m, 1H), 7.47-7.23 (m, 8H), 5.14 (d, J=3.2 Hz, 1H), 4.65-4.20 (m, 6H), 4.05-3.87 (m, 2H), 3.71-3.32 (m, 15H), 2.89 (s, 3H), 2.45-2.41 (m, 4H), 2.21-1.87 (m, 3H), 1.10-0.91 (m, 15H). LCMS: RT=2.233 min, m/z 1130.7 [M+H]⁺.

### Example C-17. Synthesis of 8-(3,5-difluoro-2-pyridyl)-N-[2-[3-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethoxy]propoxy]ethyl]-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxamide

### A. Step 1

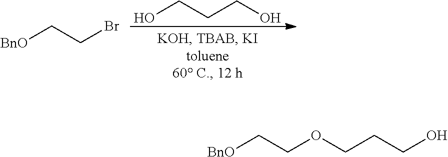

To a solution of 2-bromoethoxymethylbenzene (10 g, 46.49 mmol, 7.35 mL) and propane-1,3-diol (7.08 g, 92.99 mmol, 6.72 mL) in toluene (30 mL) were added TBAB (7.49 g, 23.25 mmol), KI (3.86 g, 23.25 mmol) and KOH (13.04 g, 232.46 mmol) at 25° C. The mixture was heated to 60° C. and stirred for 12 hours. The reaction mixture was diluted with water (20 mL) and extracted with Ethyl acetate (30 mL×3). The combined organic phase was washed with brine (50 mL×3), dried over anhydrous Na₂SO₄, filtered and concentrated in vacuo. The residue was purified by column chromatography on silica gel (Petroleum ether/Ethyl acetate=2/1) to afford the desired product 3-(2-benzyloxyethoxy)propan-1-ol (5.6 g, 26.63 mmol, 57.28% yield) as a yellow oil. ¹H NMR: CDCl₃, 400 MHz. δ 7.38-7.28 (m, 5H), 4.57 (s, 2H), 3.82-3.77 (m, 2H), 3.71-3.67 (m, 2H), 3.66-3.61 (m, 4H), 1.90-1.80 (m, 2H). LCMS: RT=0.348 min, m/z 233.0 [M+Na]⁻.

### B. Step 2

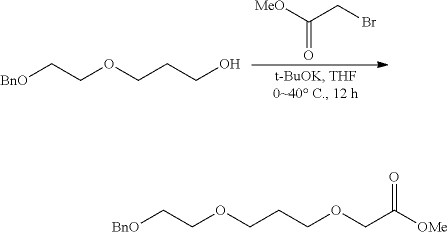 [SMILES: COC(=O)CBr ; OCCCOCCOCc1ccccc1 ; COC(=O)COCCCOCCOCc1ccccc1]

To a solution of 3-(2-benzyloxyethoxy)propan-1-ol (5.54 g, 26.35 mmol) in THE (50 mL) was added t-BuOK (1 M in THF, 52.69 mmol, 52.69 mL) at 0° C. The mixture was stirred at 40° C. for 0.5 hour. To the mixture was added methyl 2-bromoacetate (12.09 g, 79.04 mmol, 7.48 mL) at 0° C. The mixture was stirred at 25° C. for 11.5 hours. The reaction mixture was diluted with water (30 mL) and extracted with Ethyl acetate (40 mL×3). The combined organic phase was washed with brine (50 mL×3), dried over anhydrous Na₂SO₄, filtered and concentrated in vacuo. The residue was purified by column chromatography on silica gel (Petroleum ether/Ethyl acetate=1/1) to afford the desired product methyl 2-[3-(2-benzyloxyethoxy)propoxy]acetate (2.34 g, 8.29 mmol, 31.46% yield) as a yellow oil. ¹H NMR: CDCl₃, 400 MHz. δ 7.40-7.28 (m, 5H), 4.60-4.56 (m, 2H), 4.10-4.01 (m, 2H), 3.80-3.74 (m, 2H), 3.64-3.61 (m, 5H), 3.60-3.53 (m, 2H), 3.45 (s, 2H), 2.0-1.87 (m, 2H). LCMS: RT=0.449 min, m/z 305 [M+Na]⁺.

### C. Step 3

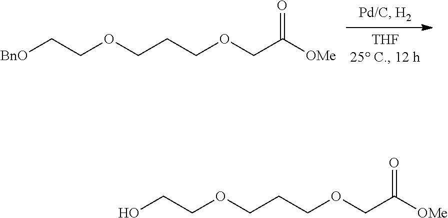 [SMILES: COC(=O)COCCCOCCOCc1ccccc1 ; COC(=O)COCCCOCCO]

To a solution of methyl 2-[3-(2-benzyloxyethoxy)propoxy]acetate (2.34 g, 8.29 mmol) in THE (40 mL) was added Pd/C (1 g, 939.67 μmol, 10% purity) under N₂. The mixture was stirred at 25° C. for 12 hours under H₂ (45 Psi). The reaction mixture was filtered and the filtrate was concentrated in vacuo to afford the desired product methyl 2-[3-(2-hydroxyethoxy)propoxy]acetate (1.35 g, crude) as a yellow oil. ¹H NMR: CDCl₃, 400 MHz. δ 4.12-4.00 (m, 2H), 3.78-3.72 (m, 3H), 3.71-3.52 (m, 6H), 3.50-3.40 (m, 2H), 1.99-1.87 (m, 2H).

### D. Step 4

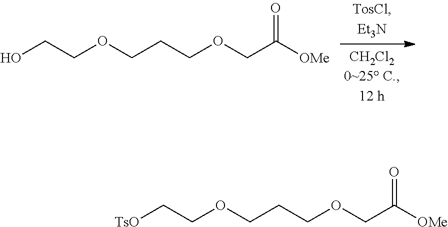 [SMILES: COC(=O)COCCCOCCO ; COC(=O)COCCCOCCOS(=O)(=O)c1ccc(C)cc1]

To a solution of methyl 2-[3-(2-hydroxyethoxy)propoxy]acetate (1.3 g, 6.76 mmol) in CH₂Cl₂ (10 mL) was added Et3N (2.74 g, 27.05 mmol, 3.77 mL) and TosCl (3.87 g, 20.29 mmol) at 0° C. The mixture was stirred at 25° C. for 12 hours. The reaction mixture was diluted with H₂O (8 mL) and extracted with Dichloromethane (15 mL×3). The combined organic phase was washed with brine (20 mL×3), dried over anhydrous Na₂SO₄, filtered and concentrated in vacuo. The residue was purified by column chromatography on silica gel (Petroleum ether/Ethyl acetate=1/1) to afford the desired product methyl 2-[3-[2-(p-tolylsulfonyloxy)ethoxy]propoxy]acetate (1.9 g, 5.49 mmol, 81.10% yield) as a yellow oil. ¹H NMR: CDCl₃, 400 MHz. δ 7.84-7.78 (m, 2H), 7.37-7.34 (m, 2H), 4.22-4.14 (m, 3H), 4.08-4.02 (m, 2H), 3.76 (s, 2H), 3.64-3.61 (m, 2H), 3.58-3.50 (m, 2H), 3.49-3.45 (m, 2H), 2.46 (s, 3H), 1.92-1.79 (m, 2H). LCMS: RT=0.450 min, m/z 369.0 [M+Na]⁺.

### E. Step 5

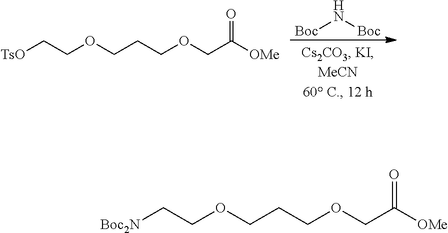

To a solution of methyl 2-[3-[2-(p-tolylsulfonyloxy)ethoxy]propoxy]acetate (1.75 g, 5.05 mmol) and tert-butyl N-tert-butoxycarbonylcarbamate (1.65 g, 7.58 mmol) in MeCN (30 mL) was added KI (838.65 mg, 5.05 mmol) and Cs₂CO₃ (4.94 g, 15.16 mmol) at 25° C. The mixture was heated to 60° C. and stirred for 12 hours. The reaction mixture was diluted with water (20 mL) and extracted with Ethyl acetate (20 mL×3). The combined organic phase was washed with brine (20 mL), dried over anhydrous Na₂SO₄, filtered and concentrated in vacuo.

The residue was purified by column chromatography on silica gel (Petroleum ether/Ethyl acetate=3/1) to afford the desired product methyl 2-[3-[2-[bis(tert-butoxycarbonyl)amino]ethoxy]propoxy]acetate (470 mg, 1.20 mmol, 23.77% yield) as a yellow oil. ¹H NMR: CDCl₃, 400 MHz. δ 4.08 (s, 2H), 3.81-3.78 (m, 2H), 3.76 (s, 3H), 3.63-3.59 (m, 2H), 3.56 (s, 2H), 3.55-3.53 (m, 2H), 1.89-1.85 (m, 2H), 1.51 (s, 18H). LCMS: RT=0.523 min, m/z 414.0 [M+Na]⁻.

### F. Step 6

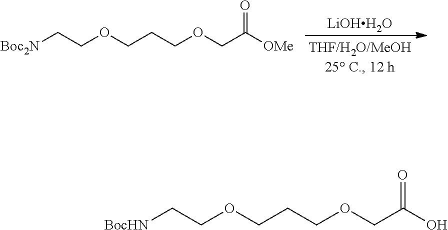

To a solution of methyl 2-[3-[2-[bis(tert-butoxycarbonyl)amino]ethoxy]propoxy]acetate (470 mg, 1.20 mmol) in THF (2 mL), MeOH (2 mL) and H₂O (2 mL) was added LiOH H₂O (151.14 mg, 3.60 mmol). The mixture was stirred at 25° C. for 2 hours. The pH of the reaction mixture was adjusted to 6 by addition of 2 N aqueous HCl solution. The mixture was diluted with water (3 mL) and extracted with Ethyl acetate (5 mL×3). The combined phase was washed with brine (6 mL×3), dried over anhydrous Na₂SO₄, filtered and filtrate concentrated in vacuo to afford the desired product 2-[3-[2-(tert-butoxycarbonylamino)ethoxy]propoxy]acetic acid (290 mg, 1.05 mmol, 87.10% yield) as a yellow oil. ¹H NMR: CDCl₃, 400 MHz. δ 4.74-4.63 (m, 1H), 4.04-3.91 (m, 2H), 3.70-3.56 (m, 6H), 3.36-3.25 (m, 2H), 1.94-1.89 (m, 2H), 1.45 (s, 9H). LCMS: RT=0.274 min, m/z 299.8 [M+Na]⁺.

### G. Step 7

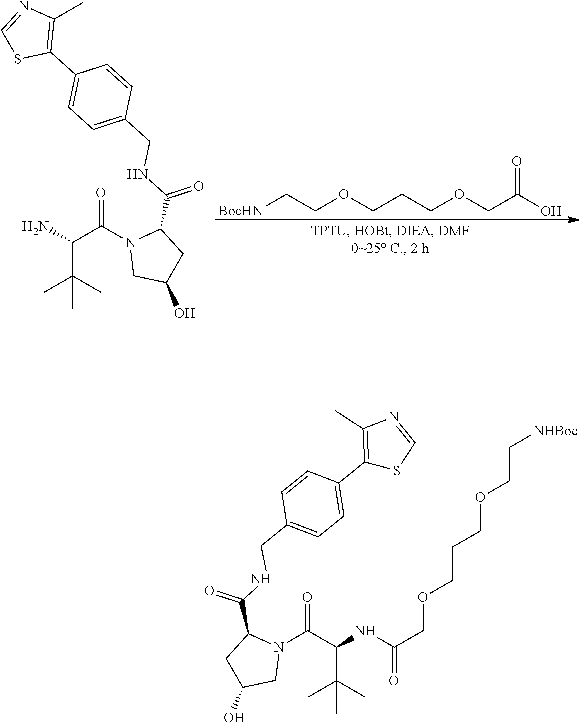 [SMILES: Cc1ncsc1-c1ccc(CNC(=O)[C@@H]2C[C@@H](O)CN2C(=O)[C@@H](N)C(C)(C)C)cc1 ; CC(C)(C)OC(=O)NCCOCCCOCC(=O)O ; Cc1ncsc1-c1ccc(CNC(=O)[C@@H]2C[C@@H](O)CN2C(=O)[C@@H](NC(=O)COCCCOCCNC(=O)OC(C)(C)C)C(C)(C)C)cc1]

To a solution of 2-[3-[2-(tert-butoxycarbonylamino)ethoxy]propoxy]acetic acid (106.88 mg, 385.42 μmol) and (2S,4R)-1-[(2S)-2-amino-3,3-dimethyl-butanoyl]-4-hydroxy-N-[[4-(4-methylthiazol-5-yl)phenyl]methyl]pyrrolidine-2-carboxamide (150 mg, 321.18 μmol, HCl salt) in DMF (2 mL) were added DIEA (166.04 mg, 1.28 mmol, 223.77 μL), TPTU (190.82 mg, 642.37 μmol) and HOBt (86.80 mg, 642.37 μmol) at 0° C. The mixture was stirred at 25° C. for 2 hours. The reaction mixture was diluted with water (2 mL) and extracted with Dichloromethane/Methanol (10/1, 4 mL×3). The combined phase was washed with brine (6 mL×3), dried over anhydrous Na₂SO₄, filtered and concentrated in vacuo. The residue was purified by preparative TLC on silica gel (Dichloromethane/Methanol=10/1) to afford the desired product tert-butyl N-[2-[3-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethoxy]propoxy]ethyl]carbamate (170 mg, 246.43 μmol, 76.72% yield) as a yellow oil. LCMS: RT=0.449 min, m/z 690.3 [M+H]⁺.

### H. Step 8

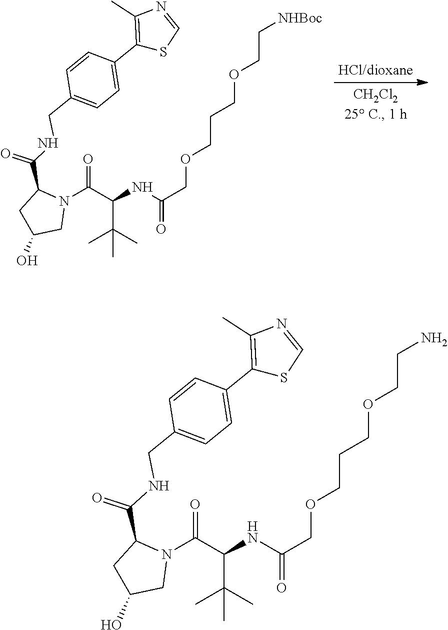 [SMILES: Cc1ncsc1-c1ccc(CNC(=O)[C@@H]2C[C@@H](O)CN2C(=O)[C@@H](NC(=O)COCCCOCCNC(=O)OC(C)(C)C)C(C)(C)C)cc1 ; Cc1ncsc1-c1ccc(CNC(=O)[C@@H]2C[C@@H](O)CN2C(=O)[C@@H](NC(=O)COCCCOCCN)C(C)(C)C)cc1]

To a solution of tert-butyl N-[2-[3-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethoxy]propoxy]ethyl]carbamate (170 mg, 246.43 μmol) in CH₂Cl₂ (6 mL) was added HCl/dioxane (2 M in dioxane, 4.0 mmol, 2.0 mL). The mixture was stirred at 25° C. for 1 hour. The reaction mixture was concentrated in vacuo to afford the desired product (2S,4R)-1-[(2S)-2-[[2-[3-(2-aminoethoxy)propoxy]acetyl]amino]-3,3-dimethyl-butanoyl]-4-hydroxy-N-[[4-(4-methylthiazol-5-yl)phenyl]methyl]pyrrolidine-2-carboxamide (150 mg, 239.54 μmol, 97.20% yield, HCl salt) as a yellow oil. ¹H NMR: DMSO-d₆, 400 MHz. δ 9.02 (s, 1H), 8.67-8.60 (m, 1H), 7.90 (brs, 3H), 7.44-7.38 (m, 4H), 4.61-4.52 (m, 1H), 4.47-4.22 (m, 6H), 3.94-3.88 (m, 4H), 3.55-3.47 (m, 6H), 3.17-3.08 (m, 2H), 2.98-2.91 (m, 2H), 2.45 (s, 3H), 1.85-1.77 (m, 2H), 0.94 (s, 9H). LCMS: RT=0.324 min, m/z=590.2 [M+H]⁺.

### I. Step 9

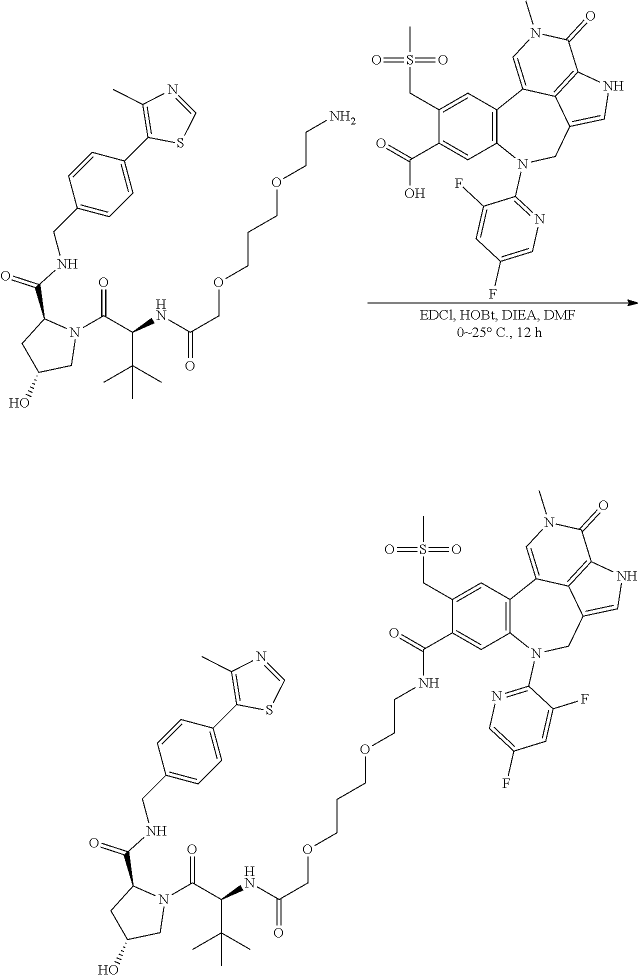 [SMILES: Cc1ncsc1-c1ccc(CNC(=O)[C@@H]2C[C@@H](O)CN2C(=O)[C@@H](NC(=O)COCCCOCCN)C(C)(C)C)cc1 ; Cn1cc2c3c(c[nH]c3c1=O)CN(c1ncc(F)cc1F)c1cc(C(=O)O)c(CS(C)(=O)=O)cc1-2 ; Cc1ncsc1-c1ccc(CNC(=O)[C@@H]2C[C@@H](O)CN2C(=O)[C@@H](NC(=O)COCCCOCCNC(=O)c2cc3c(cc2CS(C)(=O)=O)-c2cn(C)c(=O)c4[nH]cc(c24)CN3c2ncc(F)cc2F)C(C)(C)C)cc1]

To a solution of 8-(3,5-difluoro-2-pyridyl)-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxylic acid (100 mg, 199.81 μmol) and (2S,4R)-1-[(2S)-2-[[2-[3-(2-aminoethoxy)propoxy]acetyl]amino]-3,3-dimethyl-butanoyl]-4-hydroxy-N-[[4-(4-methylthiazol-5-yl)phenyl]methyl]pyrrolidine-2-carboxamide (137.63 mg, 219.79 μmol, HCl salt) in DMF (2 mL) were added DIEA (154.94 mg, 1.20 mmol, 208.82 μL) and EDCI (114.91 mg, 599.43 μmol) and HOBt (81.00 mg, 599.43 μmol) at 0° C. The mixture was stirred at 25° C. for 12 hours. The reaction mixture was diluted with water (2 mL) and extracted with Dichloromethane/Methanol (10/1, 4 mL×3). The combined phase was washed with brine (10 mL×3), dried over anhydrous Na₂SO₄, filtered and concentrated in vacuo. The residue was purified by preparative HPLC (column: Waters xbridge 150*25 mm*10 um; mobile phase: [water (NH₄HCO₃)-ACN]; gradient: 22%-52% B over 10 min) to afford the desired product 8-(3,5-difluoro-2-pyridyl)-N-[2-[3-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethoxy]propoxy]ethyl]-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxamide (34.56 mg, 31.80 μmol, 15.91% yield, 98.6% purity) as a yellow solid. ¹H NMR: DMSO-d₆, 400 MHz. (11.90 (s, 1H), 8.96 (s, 1H), 8.57 (s, 1H), 8.48-8.40 (m, 1H), 8.06 (d, J=2.8 Hz, 1H), 7.92 (s, 1H), 7.75 (s, 1H), 7.64-7.56 (m, 1H), 7.45-7.38 (m, 5H), 7.29-7.25 (m, 2H), 6.14-4.94 (m, 2H), 4.60-4.20 (m, 7H), 3.90 (s, 2H), 3.70-3.56 (m, 6H), 3.53-3.41 (m, 8H), 2.89 (s, 3H), 2.43 (s, 3H), 2.08-2.03 (m, 1H), 1.92-1.89 (m, 1H), 1.75-7.72 (m, 2H), 0.94 (s, 9H). LCMS: RT=1.992 min, m/z 1072.6 [M+H]⁺.

### Example C-18. Synthesis of 8-(3,5-difluoro-2-pyridyl)-N-[2-[2-[2-[2-[[(1S)-1-[(2S,4R)-4-hydroxy-2-[[(1S)-1-[4-(4-methylthiazol-5-yl)phenyl]ethyl]carbamoyl]pyrrolidine-1-carbonyl]-2,2-dimethyl-propyl]amino]-2-oxo-ethoxy]ethoxy]ethoxy]ethyl]-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxamide

### A. Step 1

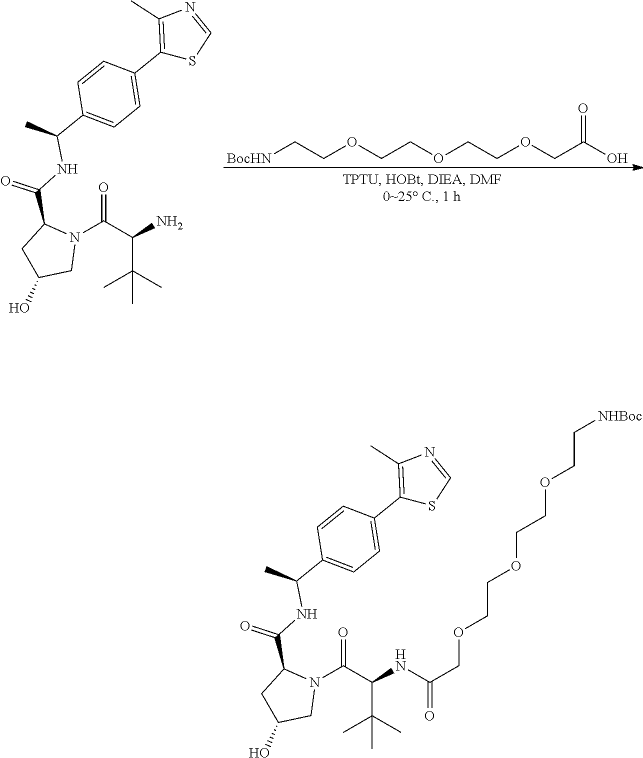 [SMILES: Cc1ncsc1-c1ccc([C@H](C)NC(=O)[C@@H]2C[C@@H](O)CN2C(=O)[C@@H](N)C(C)(C)C)cc1 ; CC(C)(C)OC(=O)NCCOCCOCCOCC(=O)O ; Cc1ncsc1-c1ccc([C@H](C)NC(=O)[C@@H]2C[C@@H](O)CN2C(=O)[C@@H](NC(=O)COCCOCCOCCNC(=O)OC(C)(C)C)C(C)(C)C)cc1]

To a mixture of 2-[2-[2-[2-(tert-butoxycarbonylamino)ethoxy]ethoxy]ethoxy]acetic acid (250 mg, 813.43 μmol), (2S,4R)-1-[(2S)-2-amino-3,3-dimethyl-butanoyl]-4-hydroxy-N-[(1S)-1-[4-(4-methylthiazol-5-yl)phenyl]ethyl]pyrrolidine-2-carboxamide (469.56 mg, 976.12 mol, HCl salt), HOBt (164.87 mg, 1.22 mmol) and DIPEA (630.78 mg, 4.88 mmol, 850.11 μL) in DMF (3 mL) was added TPTU (362.46 mg, 1.22 mmol) at 0° C. Then the mixture was warmed to 25° C. and stirred for 1 hour. The mixture was diluted with water (30 mL) and extracted with ethyl acetate (10 mL×3). The combined organic phase was washed with brine (30 mL), dried over anhydrous Na₂SO₄, filtered and concentrated in vacuo. The residue was purified by preparative TLC on silica gel (Dichloromethane/Methanol=5/1) to afford the desired product tert-butyl N-[2-[2-[2-[2-[[(1S)-1-[(2S,4R)-4-hydroxy-2-[[(1S)-1-[4-(4-methylthiazol-5-yl)phenyl]ethyl]carbamoyl]pyrrolidine-1-carbonyl]-2,2-dimethyl-propyl]amino]-2-oxo-ethoxy]ethoxy]ethoxy]ethyl]carbamate (420 mg, 568.27 μmol, 69.86% yield, 99.3% purity) as a yellow oil. ¹H NMR: CDCl₃, 400 MHz. δ 8.68 (s, 1H), 7.50-7.30 (m, 6H), 5.12-5.07 (m, 1H), 4.76 (t, J=8.0 Hz, 1H), 4.63-4.48 (m, 2H), 4.14-4.03 (m, 2H), 3.75-3.69 (m, 4H), 3.68-3.60 (m, 5H), 3.55 (t, J=5.2 Hz, 2H), 3.50 (s, 2H), 3.38-3.24 (m, 2H), 2.56-2.50 (m, 4H), 2.18-2.00 (m, 1H), 1.49 (d, J=7.2 Hz, 3H), 1.44 (s, 9H), 1.08 (s, 9H).

LCMS: RT=0.450 min, m/z 734.2 [M+H]⁺.

### B. Step 2

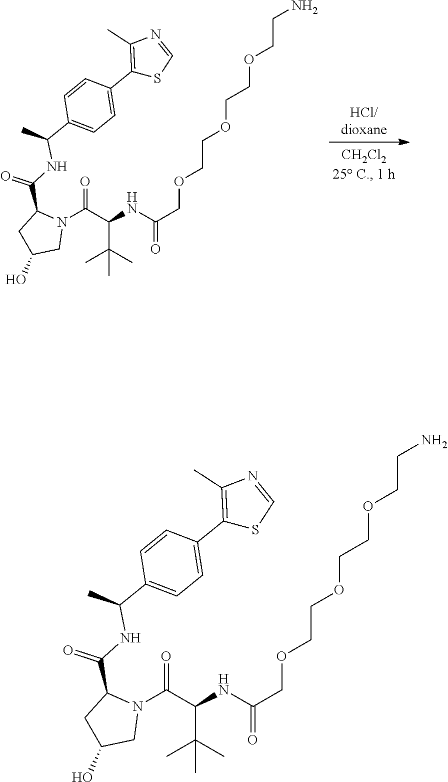 [SMILES: Cc1ncsc1-c1ccc([C@H](C)NC(=O)[C@@H]2C[C@@H](O)CN2C(=O)[C@@H](NC(=O)COCCOCCOCCN)C(C)(C)C)cc1 ; Cc1ncsc1-c1ccc([C@H](C)NC(=O)[C@@H]2C[C@@H](O)CN2C(=O)[C@@H](NC(=O)COCCOCCOCCN)C(C)(C)C)cc1]

To a solution of tert-butyl N-[2-[2-[2-[2-[[(1S)-1-[(2S,4R)-4-hydroxy-2-[[(1S)-1-[4-(4-methylthiazol-5-yl)phenyl]ethyl]carbamoyl]pyrrolidine-1-carbonyl]-2,2-dimethyl-propyl]amino]-2-oxo-ethoxy]ethoxy]ethoxy]ethyl]carbamate (420 mg, 568.27 μmol) in CH₂Cl₂ (5 mL) was added HCl/dioxane (4 M in dioxane, 20.00 mmol, 5 mL) at 25° C. Then the mixture was stirred at 25° C. for 1 hour. The mixture was concentrated in vacuo to afford the desired product (2S,4R)-1-[(2S)-2-[[2-[2-[2-(2-aminoethoxy)ethoxy]ethoxy]acetyl]amino]-3,3-dimethyl-butanoyl]-4-hydroxy-N-[(1S)-1-[4-(4-methylthiazol-5-yl)phenyl]ethyl]pyrrolidine-2-carboxamide (380 mg, 566.38 μmol, 99.67% yield, 99.9% purity, HCl salt) as a yellow solid. LCMS: RT=0.317 min, m/z 634.2 [M+H]⁺.

### C. Step 3

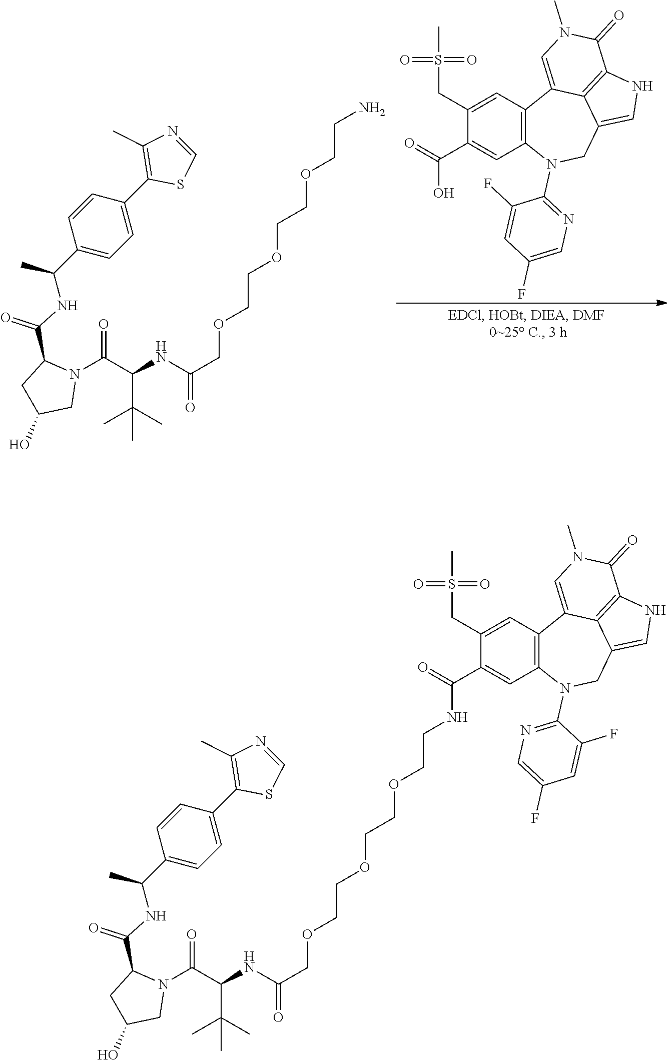 [SMILES: Cc1ncsc1-c1ccc([C@H](C)NC(=O)[C@@H]2C[C@@H](O)CN2C(=O)[C@@H](NC(=O)COCCOCCOCCN)C(C)(C)C)cc1 ; Cn1cc2c3c(c[nH]c3c1=O)CN(c1ncc(F)cc1F)c1cc(C(=O)O)c(CS(C)(=O)=O)cc1-2 ; Cc1ncsc1-c1ccc([C@H](C)NC(=O)[C@@H]2C[C@@H](O)CN2C(=O)[C@@H](NC(=O)COCCOCCOCCNC(=O)c2cc3c(cc2CS(C)(=O)=O)-c2cn(C)c(=O)c4[nH]cc(c24)CN3c2ncc(F)cc2F)C(C)(C)C)cc1]

To a mixture of 8-(3,5-difluoro-2-pyridyl)-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxylic acid (49.78 mg, 99.46 μmol), (2S,4R)-1-[(2S)-2-[[2-[2-[2-(2-aminoethoxy)ethoxy]ethoxy]acetyl]amino]-3,3-dimethyl-butanoyl]-4-hydroxy-N-[(1S)-1-[4-(4-methylthiazol-5-yl)phenyl]ethyl]pyrrolidine-2-carboxamide (80 mg, 119.36 μmol, HCl salt) and DIPEA (77.13 mg, 596.78 μmol, 103.95 μL) in DMF (1 mL) were added HOBt (20.16 mg, 149.20 μmol) and EDCI (28.60 mg, 149.20 μmol) at 0° C. Then the mixture was warmed to 25° C. and stirred for 3 hours. The mixture was filtered and the filtrate was purified by preparative HPLC (column: Phenomenex luna C18 150*25 mm*10 um; mobile phase: [water (FA)-ACN]; gradient: 27%-57% B over 10 min) to afford the desired product 8-(3,5-difluoro-2-pyridyl)-N-[2-[2-[2-[2-[[(1S)-1-[(2S,4R)-4-hydroxy-2-[[(1S)-1-[4-(4-methylthiazol-5-yl)phenyl]ethyl]carbamoyl]pyrrolidine-1-carbonyl]-2,2-dimethyl-propyl]amino]-2-oxo-ethoxy]ethoxy]ethoxy]ethyl]-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxamide (66.22 mg, 58.61 μmol, 58.93% yield, 98.8% purity) as a white solid. ¹H NMR: DMSO-d₆, 400 MHz. δ 11.92 (s, 1H), 9.07-8.91 (m, 1H), 8.52-8.40 (m, 2H), 8.11-8.03 (m, 1H), 7.96-7.89 (m, 1H), 7.75 (s, 1H), 7.66-7.56 (m, 1H), 7.45-7.33 (m, 6H), 7.29 (s, 1H), 6.07-5.80 (m, 1H), 5.15-5.10 (m, 1H), 4.95-4.85 (m, 1H), 4.61-4.19 (m, 5H), 3.95 (s, 2H), 3.64-3.47 (m, 18H), 2.90 (s, 3H), 2.45 (s, 3H), 2.09-2.00 (m, 1H), 1.81-1.71 (m, 1H), 1.35 (d, J=7.2 Hz, 3H), 0.93 (s, 9H). LCMS: RT=2.196 min, m/z 1116.6 [M+H]⁺.

### Example C-19. Synthesis of 8-(3,5-difluoro-2-pyridyl)-N-[2-[4-[[4-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethyl]piperazin-1-yl]methyl]-1-piperidyl]ethyl]-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxamide

### A. Step 1

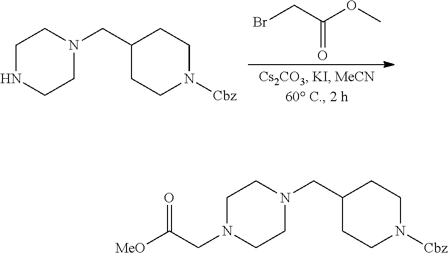

A mixture of benzyl 4-(piperazin-1-ylmethyl)piperidine-1-carboxylate (2 g, 5.12 mmol, 2HCl salt), methyl 2-bromoacetate (1.02 g, 6.66 mmol, 630.52 μL), Cs₂CO₃ (3.34 g, 10.25 mmol) and KI (850.53 mg, 5.12 mmol) in MeCN (20 mL) was heated to 60° C. and stirred for 2 hours under N₂. The reaction mixture was diluted with water (20 mL) and extracted with Dichloromethane/Methanol (10/1, 20 mL×3). The combined organic phase was washed with brine (20 mL), dried with anhydrous Na₂SO₄, filtered and concentrated in vacuo. The residue was purified by column chromatography on silica gel (Dichloromethane/Methanol=10/1) to afford the desired product benzyl 4-[[4-(2-methoxy-2-oxo-ethyl)piperazin-1-yl]methyl]piperidine-1-carboxylate (1.4 g, 3.59 mmol, 70.15% yield) as a yellow oil. ¹H NMR: DMSO-d₆, 400 MHz. δ 7.43-7.26 (m, 5H), 5.05 (s, 2H), 3.99-3.96 (m, 2H), 3.60 (s, 3H), 3.19 (s, 2H), 2.86-2.70 (m, 2H), 2.49-2.44 (m, 4H), 2.35-2.30 (m, 4H), 2.10-2.08 (m, 2H), 1.68-1.65 (m, 3H), 1.00-0.90 (m, 2H). LCMS: RT=0.288 min, m/z 390.2 [M+H]⁺.

### B. Step 2

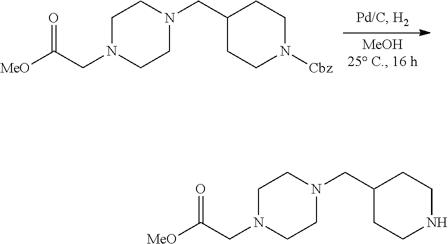 [SMILES: COC(=O)CN1CCN(CC2CCN(C(=O)OCc3ccccc3)CC2)CC1 ; COC(=O)CN1CCN(CC2CCNCC2)CC1]

To a solution of benzyl 4-[[4-(2-methoxy-2-oxo-ethyl)piperazin-1-yl]methyl]piperidine-1-carboxylate (1.4 g, 3.59 mmol) in MeOH (15 mL) was added Pd/C (500 mg, 469.84 μmol, 10% purity) at 25° C. under N₂. The mixture was stirred at 25° C. for 16 hours under H₂ (45 psi). The mixture was filtered and the filtrate was concentrated in vacuo to afford the desired product methyl 2-[4-(4-piperidylmethyl)piperazin-1-yl]acetate (750 mg, 2.94 mmol, 81.71% yield) as a white solid. ¹H NMR: DMSO-d₆, 400 MHz. δ 3.60 (s, 3H), 3.18 (s, 2H), 2.89-2.86 (m, 2H), 2.48-2.38 (m, 6H), 2.34-2.28 (m, 4H), 2.07-2.05 (m, 2H), 1.60-1.49 (m, 3H), 0.96-0.87 (m, 2H). LCMS: RT=0.131 min, m/z 256.2 [M+H]⁺.

### C. Step 3

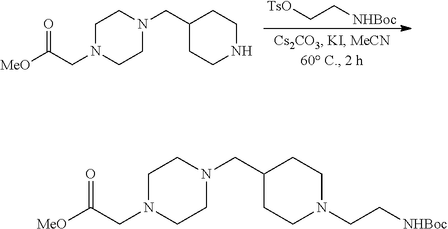 [SMILES: COC(=O)CN1CCN(CC2CCNCC2)CC1 ; Cc1ccc(S(=O)(=O)OCCNC(=O)OC(C)(C)C)cc1 ; COC(=O)CN1CCN(CC2CCN(CCNC(=O)OC(C)(C)C)CC2)CC1]

A mixture of methyl 2-[4-(4-piperidylmethyl)piperazin-1-yl]acetate (745 mg, 2.92 mmol), 2-(tert-butoxycarbonylamino)ethyl 4-methylbenzenesulfonate (1.20 g, 3.79 mmol), Cs₂CO₃ (1.90 g, 5.84 mmol) and KI (484.31 mg, 2.92 mmol) in MeCN (10 mL) was heated to 60° C. and stirred for 2 hours under N₂. The reaction mixture was diluted with water (10 mL) and extracted with Dichloromethane/Methanol (10/1, 10 mL×3). The combined organic phase was washed with brine (10 mL), dried with anhydrous Na₂SO₄, filtered and concentrated in vacuo.

The residue was purified by column chromatography on silica gel (Dichloromethane/Methanol=10/1) to afford the desired product methyl 2-[4-[[1-[2-(tert-butoxycarbonylamino)ethyl]-4-piperidyl]methyl]piperazin-1-yl]acetate (690 mg, 1.73 mmol, 59.34% yield) as a light yellow oil. ¹H NMR: DMSO-d₆, 400 MHz. δ 6.61 (brs, 1H), 3.60 (s, 3H), 3.19 (s, 2H), 3.02-3.01 (m, 2H), 2.84-2.80 (m, 2H), 2.49-2.44 (m, 4H), 2.31-2.29 (m, 6H), 2.09-2.07 (m, 2H), 1.91-1.90 (m, 2H), 1.64-1.61 (m, 2H), 1.47-1.41 (m, 1H), 1.37 (s, 9H), 1.11-1.01 (m, 2H). LCMS: RT=0.164 min, m/z 399.3 [M+H]⁺.

### D. Step 4

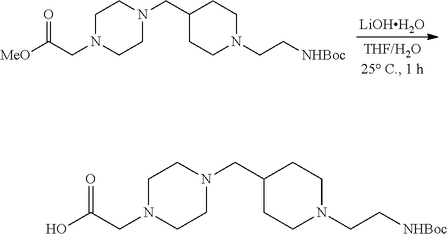 [SMILES: COC(=O)CN1CCN(CC2CCN(CCNC(=O)OC(C)(C)C)CC2)CC1 ; "LiOH·H2O" ; CC(C)(C)OC(=O)NCCN1CCC(CN2CCN(CC(=O)O)CC2)CC1]

To a solution of methyl 2-[4-[[1-[2-(tert-butoxycarbonylamino)ethyl]-4-piperidyl]methyl]piperazin-1-yl]acetate (690 mg, 1.73 mmol) in H₂O (3 mL) and THF (9 mL) was added LiOH H₂O (217.94 mg, 5.19 mmol) at 25° C. The mixture was stirred at 25° C. for 1 hour. The pH of the mixture was adjusted to 6 by addition of 2 N aqueous HCl solution, and extracted with Dichloromethane/Methanol (10/1, 10 mL×5). The combined organic phase was washed with brine (10 mL), dried with anhydrous Na₂SO₄, filtered and concentrated in vacuo.

The residue was purified by preparative HPLC (column: Waters xbridge 150*25 mm*10 um; mobile phase: [water (NH₄HCO₃)-ACN]; gradient: 0%-30% B over 10 min) to afford the desired product 2-[4-[[1-[2-(tert-butoxycarbonylamino)ethyl]-4-piperidyl]methyl]piperazin-1-yl]acetic acid (470 mg, 1.22 mmol, 70.60% yield) as a white solid. ¹H NMR: DMSO-d₆, 400 MHz. (6.58 (brs, 1H), 3.12 (s, 2H), 3.03-2.98 (m, 2H), 2.81-2.78 (m, 2H), 2.68-2.60 (m, 4H), 2.39-2.35 (m, 4H), 2.30-2.27 (m, 2H), 2.10-2.08 (m, 2H), 1.91-1.86 (m, 2H), 1.63-1.60 (m, 2H), 1.44-1.42 (m, 1H), 1.36 (s, 9H), 1.12-1.00 (m, 2H). LCMS: RT=0.118 min, m/z 385.1 [M+H]⁺.

### E. Step 5

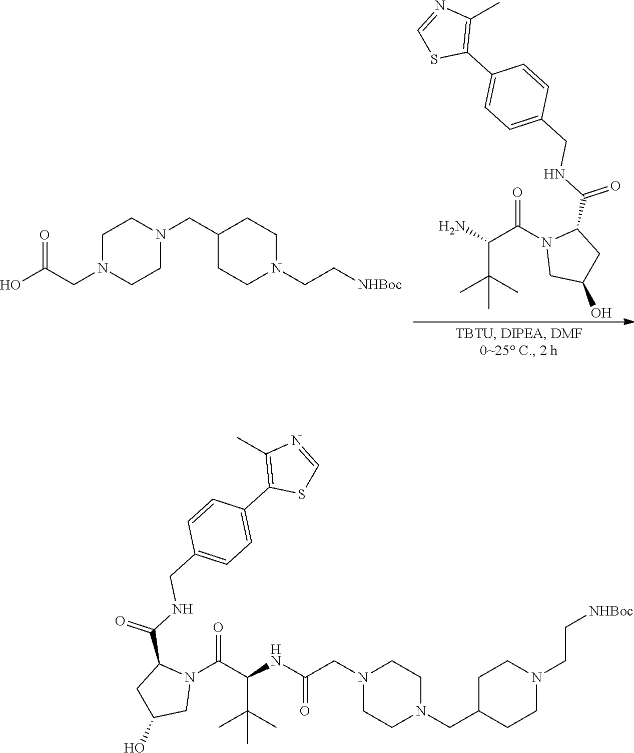 [SMILES: CC(C)(C)OC(=O)NCCN1CCC(CN2CCN(CC(=O)O)CC2)CC1 ; Cc1ncsc1-c1ccc(CNC(=O)[C@@H]2C[C@@H](O)CN2C(=O)[C@@H](N)C(C)(C)C)cc1 ; Cc1ncsc1-c1ccc(CNC(=O)[C@@H]2C[C@@H](O)CN2C(=O)[C@@H](NC(=O)CN2CCN(CC3CCN(CCNC(=O)OC(C)(C)C)CC3)CC2)C(C)(C)C)cc1]

To a solution of 2-[4-[[1-[2-(tert-butoxycarbonylamino)ethyl]-4-piperidyl]methyl]piperazin-1-yl]acetic acid (440 mg, 1.14 mmol), (2S,4R)-1-[(2S)-2-amino-3,3-dimethyl-butanoyl]-4-hydroxy-N-[[4-(4-methylthiazol-5-yl)phenyl]methyl]pyrrolidine-2-carboxamide (534.42 mg, 1.14 mmol, HCl salt) and DIPEA (887.34 mg, 6.87 mmol, 1.20 mL) in DMF (10 mL) was added TBTU (551.12 mg, 1.72 mmol) at 0° C. under N₂. The mixture was warmed to 25° C. and stirred for 2 hours under N₂. The reaction mixture was diluted with water (10 mL) and extracted with Dichloromethane/Methanol (10/1, 10 mL×3). The combined organic phase was washed with brine (10 mL), dried with anhydrous Na₂SO₄, filtered and concentrated in vacuo. The residue was purified by column chromatography on silica gel (Dichloromethane/Methanol=5/1) to afford the desired product tert-butyl N-[2-[4-[[4-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethyl]piperazin-1-yl]methyl]-1-piperidyl]ethyl]carbamate (350 mg, 439.11 μmol, 38.37% yield) as a yellow solid. ¹H NMR: DMSO-d₆, 400 MHz. δ 8.99 (s, 1H), 8.61-8.58 (m, 1H), 7.79-7.77 (m, 1H), 7.44-7.38 (m, 4H), 6.79 (brs, 1H), 5.15-5.14 (m, 1H), 4.50-4.23 (m, 6H), 4.12-4.08 (m, 1H), 3.68-3.58 (m, 2H), 3.17-3.01 (m, 8H), 2.97-2.88 (m, 2H), 2.44 (s, 3H), 2.41-2.38 (m, 4H), 2.14-2.02 (m, 4H), 2.01-1.83 (m, 2H), 1.69-1.66 (m, 2H), 1.38 (s, 9H), 1.25-1.20 (m, 1H), 1.19-1.12 (m, 2H), 0.93 (s, 9H). LCMS: RT=0.301 min, n z 797.5 [M+H]⁺.

### F. Step 6

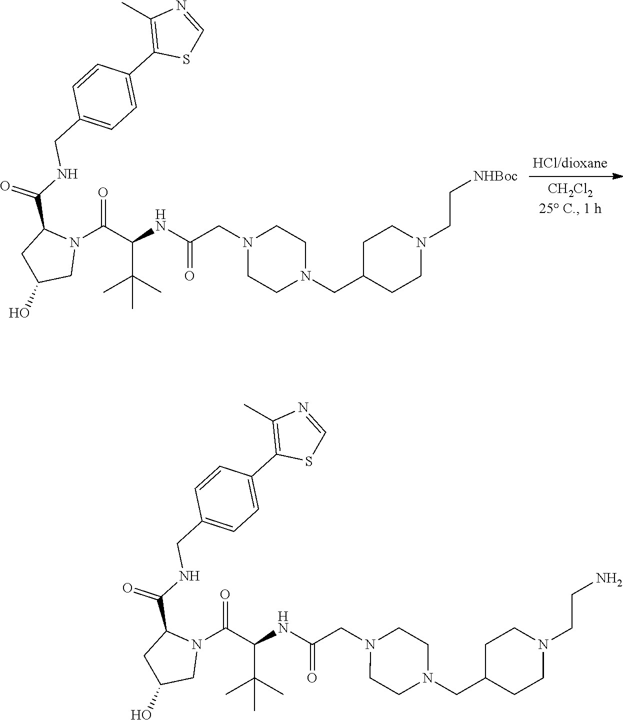 [SMILES: Cc1ncsc1-c1ccc(CNC(=O)[C@@H]2C[C@@H](O)CN2C(=O)[C@@H](NC(=O)CN2CCN(CC3CCN(CCNC(=O)OC(C)(C)C)CC3)CC2)C(C)(C)C)cc1 ; Cc1ncsc1-c1ccc(CNC(=O)[C@@H]2C[C@@H](O)CN2C(=O)[C@@H](NC(=O)CN2CCN(CC3CCN(CCN)CC3)CC2)C(C)(C)C)cc1]

A mixture of tert-butyl N-[2-[4-[[4-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethyl]piperazin-1-yl]methyl]-1-piperidyl]ethyl]carbamate (350 mg, 439.11 μmol) and HCl/dioxane (2 M in dioxane, 8.0 mmol, 4.0 mL) in CH₂Cl₂ (4 mL) was stirred at 25° C. for 1 hour under N₂. The reaction mixture was concentrated in vacuo to afford the desired product (2S,4R)-1-[(2S)-2-[[2-[4-[[1-(2-aminoethyl)-4-piperidyl]methyl]piperazin-1-yl]acetyl]amino]-3,3-dimethyl-butanoyl]-4-hydroxy-N-[[4-(4-methylthiazol-5-yl)phenyl]methyl]pyrrolidine-2-carboxamide (370 mg, 364.39 μmol, 82.98% yield, 83% purity, 4HCl salt) as a white solid. LCMS: RT=0.261 min, m/z 697.5 [M+H]⁺.

### G. Step 7

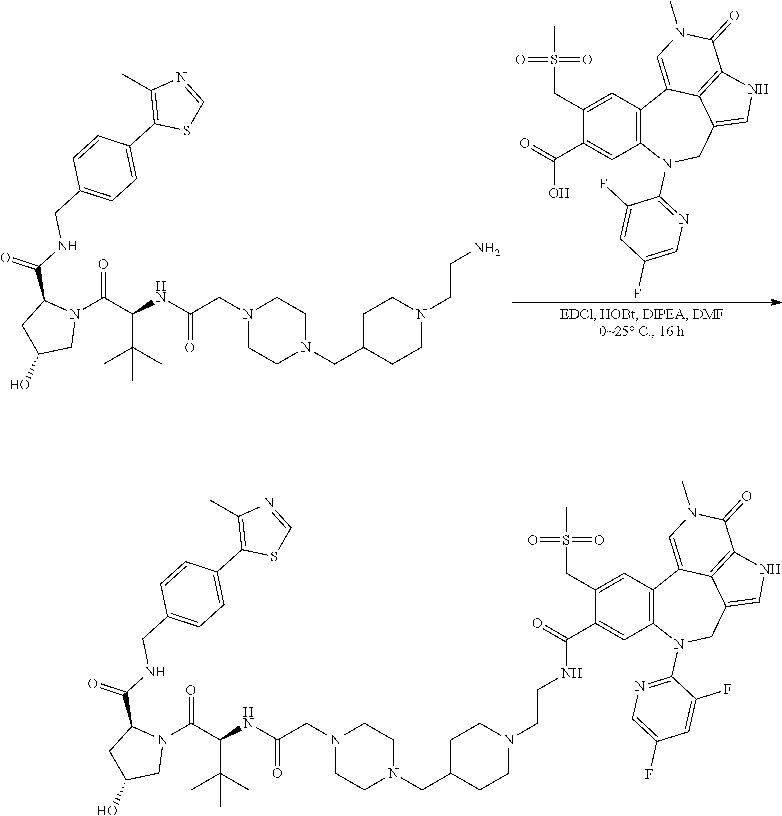 [SMILES: Cc1ncsc1-c1ccc(CNC(=O)[C@@H]2C[C@@H](O)CN2C(=O)[C@@H](NC(=O)CN2CCN(CC3CCN(CCN)CC3)CC2)C(C)(C)C)cc1 ; Cn1cc2c3c(c[nH]c3c1=O)CN(c1ncc(F)cc1F)c1cc(C(=O)O)c(CS(C)(=O)=O)cc1-2 ; Cc1ncsc1-c1ccc(CNC(=O)[C@@H]2C[C@@H](O)CN2C(=O)[C@@H](NC(=O)CN2CCN(CC3CCN(CCNC(=O)c4cc5c(cc4CS(C)(=O)=O)-c4cn(C)c(=O)c6[nH]cc(c46)CN5c4ncc(F)cc4F)CC3)CC2)C(C)(C)C)cc1]

To a solution of (2S,4R)-1-[(2S)-2-[[2-[4-[[1-(2-aminoethyl)-4-piperidyl]methyl]piperazin-1-yl]acetyl]amino]-3,3-dimethyl-butanoyl]-4-hydroxy-N-[[4-(4-methylthiazol-5-yl)phenyl]methyl]pyrrolidine-2-carboxamide (133.91 mg, 131.88 μmol, 4HCl salt), 8-(3,5-difluoro-2-pyridyl)-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxylic acid (60 mg, 119.89 μmol) and DIPEA (92.97 mg, 719.32 μmol, 125.29 μL) in DMF (1 mL) were added HOBt (24.30 mg, 179.83 μmol) and EDCI (34.47 mg, 179.83 μmol) at 0° C. under N₂.

The mixture was warmed to 25° C. and stirred for 16 hours under N₂. The reaction mixture was diluted with water (3 mL) and extracted with Dichloromethane/Methanol (10/1, 3 mL×3). The combined organic phase was washed with brine (3 mL), dried with anhydrous Na₂SO₄, filtered and concentrated in vacuo. The residue was purified by preparative HPLC (column: Phenomenex luna C18 150*25 mm*10 um; mobile phase: [water (FA)-ACN]; gradient: 10%-40% B over 10 min) to afford the desired product 8-(3,5-difluoro-2-pyridyl)-N-[2-[4-[[4-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethyl]piperazin-1-yl]methyl]-1-piperidyl]ethyl]-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxamide (26.89 mg, 20.52 μmol, 17.12% yield, 90% purity) as a yellow solid. ¹H NMR: DMSO-d₆, 400 MHz. δ 11.91 (s, 1H), 8.97 (s, 1H), 8.60-8.57 (m, 1H), 8.33-8.30 (m, 1H), 8.18 (s, 2H), 8.07-8.06 (m, 1H), 7.92 (s, 1H), 7.80-7.74 (m, 2H), 7.64-7.58 (m, 1H), 7.46-7.36 (m, 5H), 7.28-7.25 (m, 2H), 6.06-5.77 (m, 1H), 5.23-5.08 (m, 1H), 4.51-4.24 (m, 8H), 3.64-3.60 (m, 6H), 3.04-3.00 (m, 2H), 2.93 (s, 2H), 2.91 (s, 3H), 2.85-2.81 (m, 2H), 2.44 (s, 3H), 2.41-2.31 (m, 6H), 2.09-2.01 (m, 4H), 1.95-1.82 (m, 4H), 1.61-1.52 (m, 3H), 1.45-1.35 (m, 1H), 1.04-1.00 (m, 2H), 0.93 (s, 9H). LCMS: RT=1.724 min, m/z 1179.8 [M+H]⁺.

### Example C-20. Synthesis of 8-(3,5-difluoro-2-pyridyl)-N-[2-[3-[4-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethyl]piperazin-1-yl]azetidin-1-yl]ethyl]-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxamide

### A. Step 1

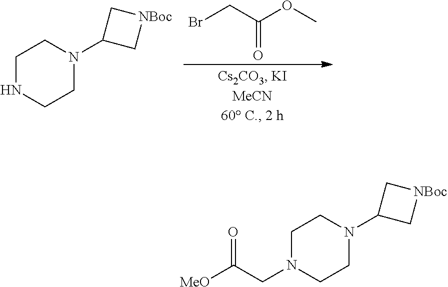

A mixture of tert-butyl 3-piperazin-1-ylazetidine-1-carboxylate (2 g, 8.29 mmol), methyl 2-bromoacetate (1.65 g, 10.77 mmol, 1.02 mL), KI (687.87 mg, 4.14 mmol) and Cs₂CO₃ (8.10 g, 24.86 mmol) in MeCN (20 mL) was heated to 60° C. and stirred for 2 hours under N₂.

The reaction mixture was diluted with water (20 mL) and extracted with Dichloromethane/Methanol (10/1, 30 mL×3). The combined organic phase was washed with brine (30 mL), dried with anhydrous Na₂SO₄, filtered and concentrated in vacuo. The residue was purified by column chromatography on silica gel (Dichloromethane/Methanol=30/1) to afford the desired product tert-butyl 3-[4-(2-methoxy-2-oxo-ethyl)piperazin-1-yl]azetidine-1-carboxylate (1.87 g, 5.97 mmol, 72.00% yield) as a yellow oil. ¹H NMR: CDCl₃, 400 MHz. δ 3.96-3.89 (m, 2H), 3.85-3.77 (m, 2H), 3.73 (s, 3H), 3.28-3.22 (m, 2H), 3.16-3.03 (m, 1H), 2.72-2.55 (m, 4H), 2.52-2.37 (m, 4H), 1.43 (s, 9H). LCMS: RT=0.214 min, m/z 314.1 [M+H]⁺.

### B. Step 2

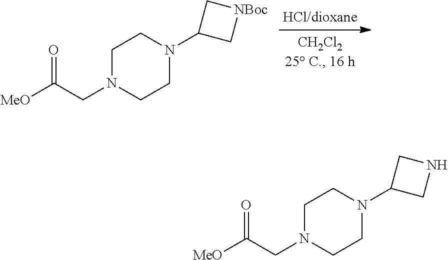 [SMILES: COC(=O)CN1CCN(C2CN(C(=O)OC(C)(C)C)C2)CC1 ; COC(=O)CN1CCN(C2CNC2)CC1]

To a mixture of tert-butyl 3-[4-(2-methoxy-2-oxo-ethyl)piperazin-1-yl]azetidine-1-carboxylate (1.87 g, 5.97 mmol) in CH₂Cl₂ (18 mL) was added HCl/dioxane (2 M in dioxane, 50.0 mmol, 25.0 mL). The mixture was stirred at 25° C. for 16 hours under N₂. The reaction mixture was concentrated in vacuo to afford the desired product methyl 2-[4-(azetidin-3-yl)piperazin-1-yl]acetate (1.88 g, 5.83 mmol, 97.65% yield, 3HCl salt) as a yellow solid. ¹H NMR: DMSO-d₆, 400 MHz. δ 9.41 (brs, 1H), 9.17 (brs, 1H), 4.15-4.05 (m, 2H), 4.00-3.96 (m, 2H), 3.73 (s, 3H), 3.58-3.55 (m, 2H), 3.32-3.17 (m, 3H), 2.51-2.51 (m, 4H), 2.49-2.49 (m, 4H). LCMS: RT=0.069 min, m/z 213.9 [M+H]⁺.

### C. Step 3

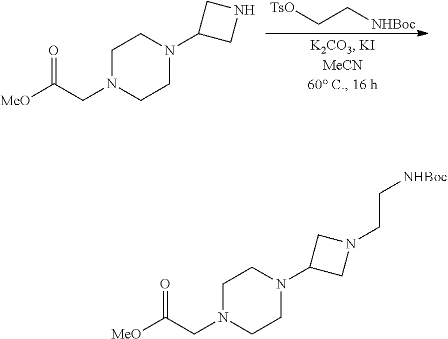 [SMILES: COC(=O)CN1CCN(C2CNC2)CC1 ; Cc1ccc(S(=O)(=O)OCCNC(=O)OC(C)(C)C)cc1 ; COC(=O)CN1CCN(C2CN(CCNC(=O)OC(C)(C)C)C2)CC1]

A mixture of methyl 2-[4-(azetidin-3-yl)piperazin-1-yl]acetate (1.86 g, 5.76 mmol, 3HCl salt), 2-(tert-butoxycarbonylamino)ethyl 4-methylbenzenesulfonate (2.73 g, 8.65 mmol), KI (956.94 mg, 5.76 mmol) and K₂CO₃ (2.39 g, 17.29 mmol) in MeCN (20 mL) was heated to 60° C. and stirred for 16 hours under N₂. The reaction mixture was diluted with water (20 mL) and extracted with Dichloromethane/Methanol (10/1, 25 mL×3). The combined organic phase was washed with brine (25 mL), dried with anhydrous Na₂SO₄, filtered and concentrated in vacuo. The residue was purified by column chromatography on silica gel (Dichloromethane/Methanol=10/1) to afford the desired product methyl 2-[4-[I-[2-(tert-butoxycarbonylamino)ethyl]azetidin-3-yl]piperazin-1-yl]acetate (975 mg, 2.74 mmol, 47.45% yield) as a yellow oil. ¹H NMR: DMSO-d₆, 400 MHz. δ 3.60 (s, 3H), 3.32-3.27 (m, 6H), 3.25-3.23 (m, 2H), 3.18-3.17 (m, 1H), 3.16-3.15 (m, 1H), 2.65-2.63 (m, 8H), 2.30-2.27 (m, 2H), 1.38 (s, 9H).

### D. Step 4

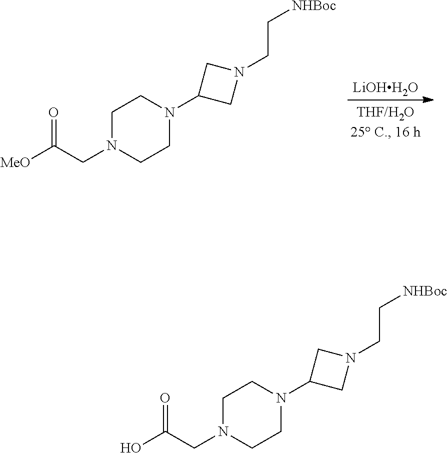 [SMILES: COC(=O)CN1CCN(C2CN(CCNC(=O)OC(C)(C)C)C2)CC1 ; "LiOH·H2O" ; CC(C)(C)OC(=O)NCCN1CC(N2CCN(CC(=O)O)CC2)C1]

To a mixture of methyl 2-[4-[1-[2-(tert-butoxycarbonylamino)ethyl]427zetidine-3-yl]piperazin-1-yl]acetate (975 mg, 2.74 mmol) in THF (9 mL) and H₂O (3 mL) was added LiOH H₂O (344.34 mg, 8.21 mmol). The mixture was stirred at 25° C. for 16 hours under N₂. The pH of the mixture was adjusted to 6 by addition of 2 N aqueous HCl solution. The reaction mixture was diluted with water (8 mL) and extracted with Ethyl acetate (10 mL×3). The combined organic phase was washed with brine (10 mL), dried with anhydrous Na₂SO₄, filtered and concentrated in vacuo. The residue was purified by preparative HPLC (column: Waters xbridge 150*25 mm*10 um; mobile phase: [water (NH₄HCO₃)-can]; gradient: 0%-25% B over 10 min) to afford the desired product 2-[4-[1-[2-(tert-butoxycarbonylamino)eth428zetidinedin-3-yl]piperazin-1-yl]acetic acid (385 mg, 1.12 mmol, 41.10% yield) as a yellow oil. ¹H NMR: DMSO-d₆, 400 MHz. δ 6.-6-6.58 (m, 1H), 3.17 (s, 2H), 3-3-3.10 (m, 2H), 2.-6-2.82 (m, 3H), 2.-4-2.71 (m, 2H), 2.-2-2.58 (m, 6H), 2.-9-2.35 (m, 2H), 2.-7-2.24 (m, 2H), 1.36 (s, 9H).

### E. Step 5

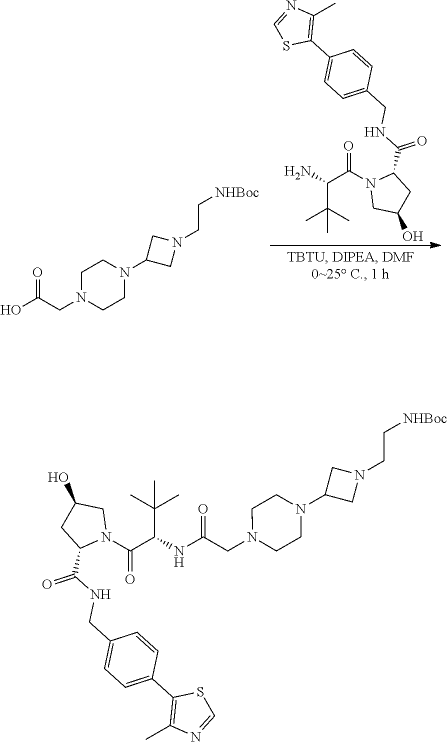 [SMILES: CC(C)(C)OC(=O)NCCN1CC(N2CCN(CC(=O)O)CC2)C1 ; Cc1ncsc1-c1ccc(CNC(=O)[C@@H]2C[C@@H](O)CN2C(=O)[C@@H](N)C(C)(C)C)cc1 ; Cc1ncsc1-c1ccc(CNC(=O)[C@@H]2C[C@@H](O)CN2C(=O)[C@@H](NC(=O)CN2CCN(C3CN(CCNC(=O)OC(C)(C)C)C3)CC2)C(C)(C)C)cc1]

To a mixture of 2-[4-[1-[2-(tert-butoxycarbonylamino)ethyl]azetidin-3-yl]piperazin-1-yl]acetic acid (359.28 mg, 1.05 mmol), (2S,4R)-1-[(2S)-2-amino-3,3-dimethyl-butanoyl]-4-hydroxy-N-[[4-(4-methylthiazol-5-yl)phenyl]methyl]pyrrolidine-2-carboxamide (490 mg, 1.05 mmol, HCl salt) and DIPEA (813.61 mg, 6.30 mmol, 1.10 mL) in DMF (5 mL) was added TBTU (505.32 mg, 1.57 mmol) at 0° C. The mixture was stirred at 25° C. for 1 hour under N₂.

The reaction mixture was diluted with water (5 mL) and extracted with Dichloromethane/Methanol (10/1, 8 mL×3). The combined organic phase was washed with brine (8 mL), dried with anhydrous Na₂SO₄, filtered and concentrated in vacuo. The residue was purified by column chromatography on silica gel (Dichloromethane/Methanol=7/1) to afford the desired product tert-butyl N-[2-[3-[4-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethyl]piperazin-1-yl]azetidin-1-yl]ethyl]carbamate (475 mg, crude) as a yellow solid. ¹H NMR: DMSO-d₆, 400 MHz. δ 8.99 (s, 1H), 8.64-8.51 (m, 1H), 7.78-7.64 (m, 1H), 7.45-7.37 (m, 4H), 6.81-6.66 (m, 1H), 5.15-5.11 (m, 1H), 4.53-4.47 (m, 1H), 4.45-4.06 (m, 5H), 3.67-3.56 (m, 4H), 3.18-3.14 (m, 2H), 2.96-2.91 (m, 4H), 2.53-2.51 (m, 12H), 2.45 (s, 3H), 1.37 (s, 9H), 0.93 (s, 9H).

### F. Step 6

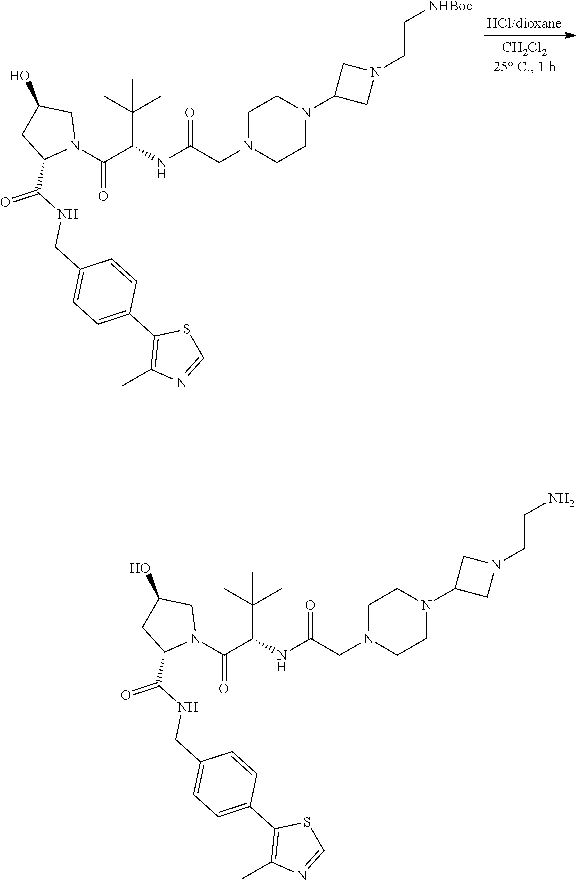 [SMILES: Cc1ncsc1-c1ccc(CNC(=O)[C@@H]2C[C@@H](O)CN2C(=O)[C@@H](NC(=O)CN2CCN(C3CN(CCNC(=O)OC(C)(C)C)C3)CC2)C(C)(C)C)cc1 ; Cc1ncsc1-c1ccc(CNC(=O)[C@@H]2C[C@@H](O)CN2C(=O)[C@@H](NC(=O)CN2CCN(C3CN(CCN)C3)CC2)C(C)(C)C)cc1]

To a mixture of tert-butyl N-[2-[3-[4-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethyl]piperazin-1-yl]azetidin-1-yl]ethyl]carbamate (475 mg, 629.16 μmol) in CH₂Cl₂ (5 mL) was added HCl/dioxane (2 M in dioxane, 20.0 mmol, 10.0 mL). The mixture was stirred at 25° C. for 1 hour under N₂. The reaction mixture was concentrated in vacuo to afford the desired product (2S,4R)-1-[(2S)-2-[[2-[4-[1-(2-aminoethyl)azetidin-3-yl]piperazin-1-yl]acetyl]amino]-3,3-dimethyl-butanoyl]-4-hydroxy-N-[[4-(4-methylthiazol-5-yl)phenyl]methyl]pyrrolidine-2-carboxamide (490 mg, crude, 4 HCl salt) as a yellow solid. LCMS: RT=0.279 min, m/z 655.3 [M+H]⁺.

### G. Step 7

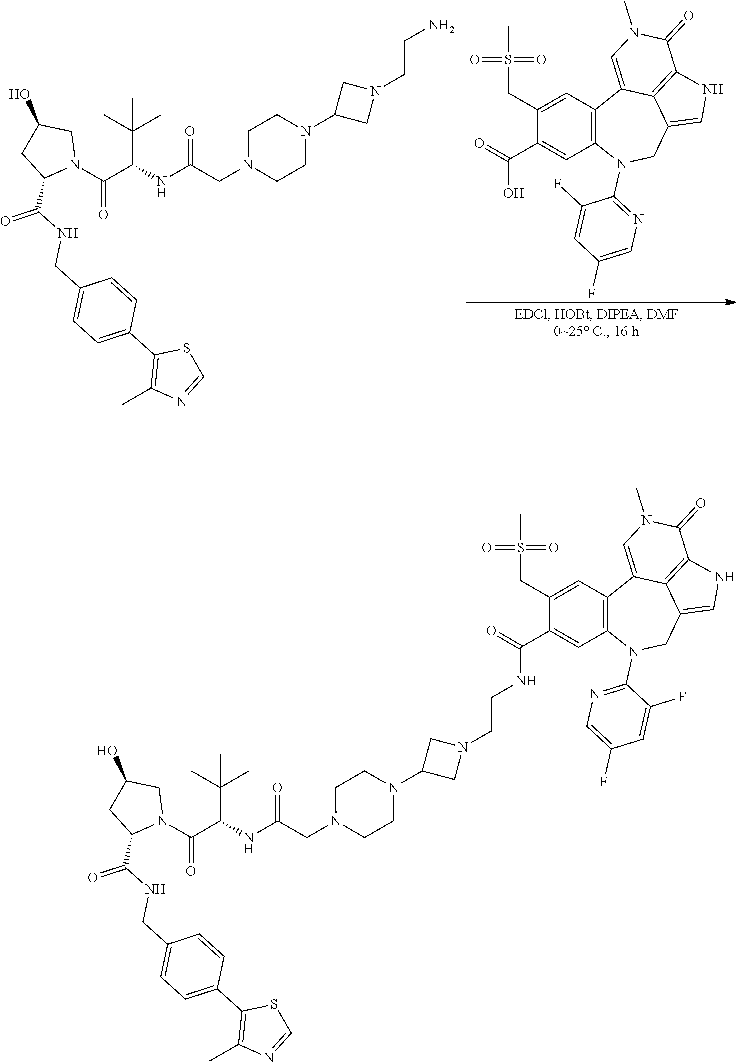 [SMILES: Cc1ncsc1-c1ccc(CNC(=O)[C@@H]2C[C@@H](O)CN2C(=O)[C@@H](NC(=O)CN2CCN(C3CN(CCN)C3)CC2)C(C)(C)C)cc1 ; Cn1cc2c3c(c[nH]c3c1=O)CN(c1ncc(F)cc1F)c1cc(C(=O)O)c(CS(C)(=O)=O)cc1-2 ; Cc1ncsc1-c1ccc(CNC(=O)[C@@H]2C[C@@H](O)CN2C(=O)[C@@H](NC(=O)CN2CCN(C3CN(CCNC(=O)c4cc5c(cc4CS(C)(=O)=O)-c4cn(C)c(=O)c6[nH]cc(c46)CN5c4ncc(F)cc4F)C3)CC2)C(C)(C)C)cc1]

To a mixture of (2S,4R)-1-[(2S)-2-[[2-[4-[1-(2-aminoethyl)azetidin-3-yl]piperazin-1-yl]acetyl]amino]-3,3-dimethyl-butanoyl]-4-hydroxy-N-[[4-(4-methylthiazol-5-yl)phenyl]methyl]pyrrolidine-2-carboxamide (211.19 mg, 263.75 μmol, 4HCl salt), 8-(3,5-difluoro-2-pyridyl)-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxylic acid (110 mg, 219.79 μmol) and DIPEA (170.44 mg, 1.32 mmol, 229.70 μL) in DMF (3 mL) were added EDCI (63.20 mg, 329.69 μmol) and HOBt (44.55 mg, 329.69 μmol) at 0° C. The mixture was stirred to 25° C. for 16 hours under N₂. The reaction mixture was diluted with water (3 mL) and extracted with Dichloromethane/Methanol (10/1, 5 mL×3). The combined organic phase was washed with brine (5 mL), dried with anhydrous Na₂SO₄, filtered and concentrated in vacuo.

The residue was purified by preparative HPLC (column: Phenomenex luna C18 150*25 mm*10 um; mobile phase: [water (FA)-ACN]; gradient: 8%-38% B over 10 min) to afford the desired product 8-(3,5-difluoro-2-pyridyl)-N-[2-[3-[4-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethyl]piperazin-1-yl]azetidin-1-yl]ethyl]-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxamide (35.18 mg, 29.54 μmol, 13.44% yield, 95.5% purity) as a yellow solid. ¹H NMR: DMSO-d₆, 400 MHz. δ 11.92 (s, 1H), 8.99 (s, 1H), 8.61-8.54 (m, 1H), 8.37-8.30 (m, 1H), 8.20 (s, 1H), 8.08-8.04 (m, 1H), 7.92 (s, 1H), 7.77-7.70 (m, 2H), 7.66-7.54 (m, 1H), 7.41-7.39 (m, 3H), 7.29-7.23 (m, 2H), 5.20-5.05 (m, 1H), 4.55-4.21 (m, 8H), 3.66-3.58 (m, 7H), 3.15-3.10 (m, 4H), 3.05-3.00 (m, 2H), 2.97-2.93 (m, 2H), 2.92 (s, 3H), 2.81-2.73 (m, 4H), 2.46-2.45 (m, 2H), 2.44 (s, 3H), 2.27-2.21 (m, 2H), 2.13-1.82 (m, 4H), 0.93 (s, 9H). LCMS: RT=1.711 min, m/z 1137.7 [M+H]⁺.

### Example C-21. Synthesis of 8-(3,5-difluoro-2-pyridyl)-N-[2-[4-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethyl]piperazin-1-yl]ethyl]-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxamide

### A. Step 1

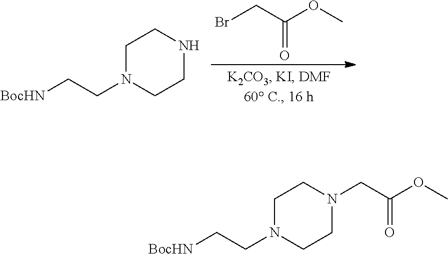

A mixture of tert-butyl N-(2-piperazin-1-ylethyl)carbamate (1 g, 4.36 mmol), methyl 2-bromoacetate (733.79 mg, 4.80 mmol, 454.08 μL), K₂CO₃ (1.21 g, 8.72 mmol) and KI (361.95 mg, 2.18 mmol) in DMF (10 mL) was heated to 60° C. and stirred for 16 hours under N₂. The reaction mixture was diluted with water (10 mL). The mixture was extracted with Ethyl acetate (15 mL×3). The combined organic phase was washed with brine (30 mL), dried with anhydrous Na₂SO₄, filtered and concentrated in vacuo. The residue was purified by column chromatography on silica gel (Dichloromethane/Methanol=20/1) to afford the desired product methyl 2-[4-[2-(tert-butoxycarbonylamino)ethyl]piperazin-1-yl]acetate (1 g, 3.32 mmol, 76.09% yield,) as a yellow oil. ¹H NMR: DMSO-d₆, 400 MHz. δ 6.63-6.59 (m, 1H), 3.60 (s, 3H), 3.19 (s, 2H), 3.04-2.97 (m, 2H), 2.47-2.27 (m, 10H), 1.37 (s, 9H).

### B. Step 2

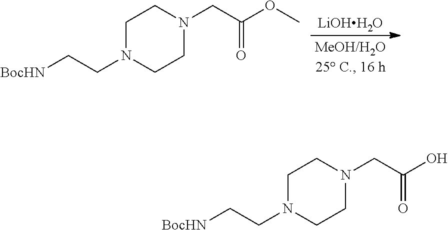

To a solution of methyl 2-[4-[2-(tert-butoxycarbonylamino)ethyl]piperazin-1-yl]acetate (1 g, 3.32 mmol) in MeOH (9 mL) and H₂O (3 mL) was added LiOH H₂O (417.68 mg, 9.95 mmol) at 25° C. The mixture was stirred at 25° C. for 16 hours. The pH of the mixture was adjusted to 6 by addition of 2 N aqueous HCl solution and extracted with Dichloromethane/Methanol (10/1, 10 mL×5). The combined organic phase was washed with brine (10 mL), dried with anhydrous Na₂SO₄, filtered and concentrated in vacuo. The residue was purified by preparative HPLC (column: YMC Triart C18 70*250 mm*7 um; mobile phase: [water (NH₄HCO₃)-ACN]; gradient: 0%-30% B over 20 min) to afford the desired product 2-[4-[2-(tert-butoxycarbonylamino)ethyl]piperazin-1-yl]acetic acid (950 mg, 3.31 mmol, 99.64% yield, 100% purity) as a white solid ¹H NMR: DMSO-d₆, 400 MHz. δ 6.64-6.60 (m, 1H), 4.29-3.90 (m, 6H), 3.13 (s, 2H), 3.05-2.97 (m, 2H), 2.68-2.60 (m, 2H), 2.46-2.40 (m, 2H), 2.33-2.28 (m, 2H), 1.37 (s, 9H). LCMS: RT=0.131, m/z 287.9 [M+H]⁺.

### C. Step 3

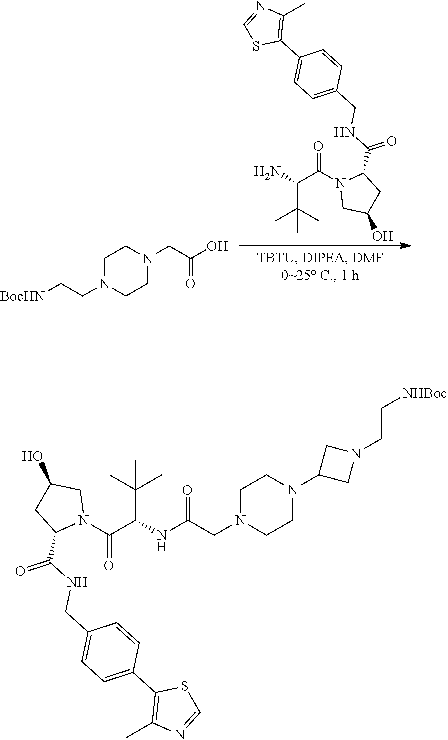 [SMILES: Cc1ncsc1-c1ccc(CNC(=O)[C@@H]2C[C@@H](O)CN2C(=O)[C@@H](N)C(C)(C)C)cc1 ; CC(C)(C)OC(=O)NCCN1CCN(CC(=O)O)CC1 ; Cc1ncsc1-c1ccc(CNC(=O)[C@@H]2C[C@@H](O)CN2C(=O)[C@@H](NC(=O)CN2CCN(C3CN(CCNC(=O)OC(C)(C)C)C3)CC2)C(C)(C)C)cc1]

To a solution of 2-[4-[2-(tert-butoxycarbonylamino)ethyl]piperazin-1-yl]acetic acid (101.52 mg, 353.30 μmol), (2S,4R)-1-[(2S)-2-amino-3,3-dimethyl-butanoyl]-4-hydroxy-N-[[4-(4-methylthiazol-5-yl)phenyl]methyl]pyrrolidine-2-carboxamide (150 mg, 321.18 μmol, HCl salt) and DIEA (249.06 mg, 1.93 mmol, 335.67 μL) in DMF (1.5 mL) was added TBTU (154.69 mg, 481.77 μmol) at 0° C. under N₂. The mixture warmed to 25° C. and stirred for 1 hour. The reaction mixture was diluted with water (3 mL) and extracted with Dichloromethane/Methanol (10/1, 5 mL×3). The combined organic phase was washed with brine (5 mL), dried with anhydrous Na₂SO₄, filtered and concentrated in vacuo. The residue was purified by preparative TLC on silica gel (Dichloromethane/Methanol=6/1) to afford the desired product tert-butyl N-[2-[4-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethylpropyl]amino]-2-oxo-ethyl]piperazin-1-yl]ethyl]carbamate (110 mg, 155.64 μmol, 48.46% yield, 99.03% purity) as a yellow oil. LCMS: RT=0.360, m/z 700.3 [M+H]⁺.

### D. Step 4

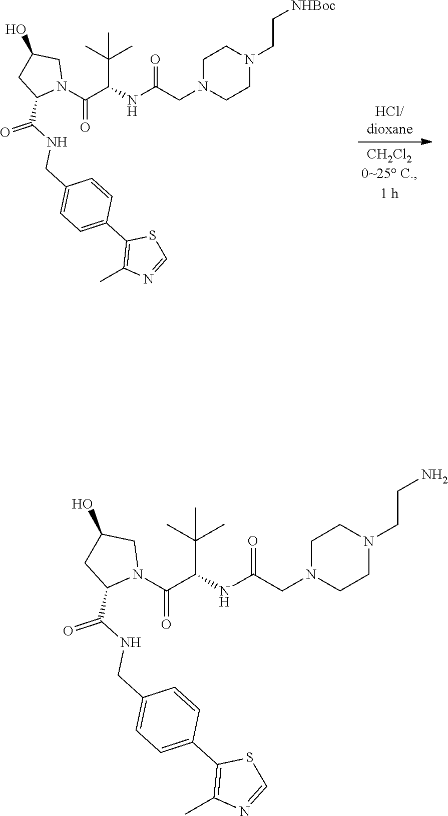 [SMILES: Cc1ncsc1-c1ccc(CNC(=O)[C@@H]2C[C@@H](O)CN2C(=O)[C@@H](NC(=O)CN2CCN(CCNC(=O)OC(C)(C)C)CC2)C(C)(C)C)cc1 ; Cc1ncsc1-c1ccc(CNC(=O)[C@@H]2C[C@@H](O)CN2C(=O)[C@@H](NC(=O)CN2CCN(CCN)CC2)C(C)(C)C)cc1]

To a mixture of tert-butyl N-[2-[4-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethyl]piperazin-1-yl]ethyl]carbamate (110 mg, 157.16 μmol) in CH₂Cl₂ (0.9 mL) was added HCl/dioxane (4 M in dioxane, 1.2 mmol, 0.3 mL) at 25° C. The mixture was stirred for 1 hour under N₂. The reaction mixture was filtered and the filtrate was concentrated in vacuo to afford the desired product (2S,4R)-1-[(2S)-2-[[2-[4-(2-aminoethyl)piperazin-1-yl]acetyl]amino]-3,3-dimethyl-butanoyl]-4-hydroxy-N-[[4-(4-methylthiazol-5-yl)phenyl]methyl]pyrrolidine-2-carboxamide (110 mg, crude, 3HCl salt) as a yellow solid. LCMS: RT=0.275, m/z 600.3 [M+H]⁺.

### E. Step 5

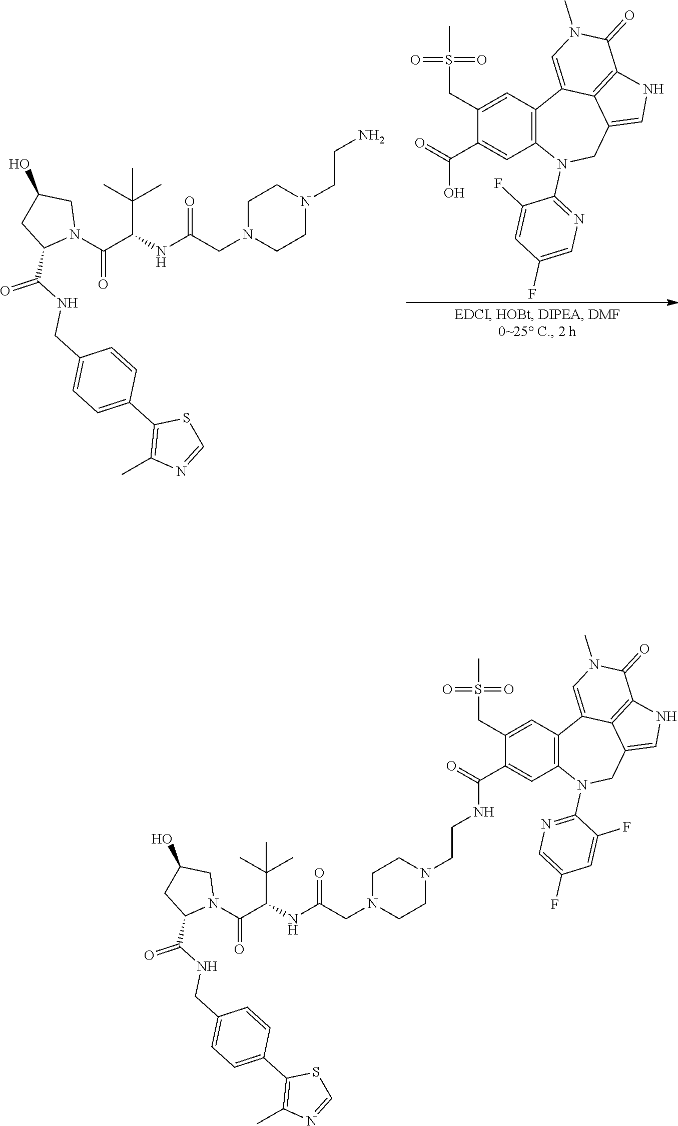 [SMILES: Cc1ncsc1-c1ccc(CNC(=O)[C@@H]2C[C@@H](O)CN2C(=O)[C@@H](NC(=O)CN2CCN(CCN)CC2)C(C)(C)C)cc1 ; Cn1cc2c3c(c[nH]c3c1=O)CN(c1ncc(F)cc1F)c1cc(C(=O)O)c(CS(C)(=O)=O)cc1-2 ; Cc1ncsc1-c1ccc(CNC(=O)[C@@H]2C[C@@H](O)CN2C(=O)[C@@H](NC(=O)CN2CCN(CCNC(=O)c3cc4c(cc3CS(C)(=O)=O)-c3cn(C)c(=O)c5[nH]cc(c35)CN4c3ncc(F)cc3F)CC2)C(C)(C)C)cc1]

To a solution of (2S,4R)-1-[(2S)-2-[[2-[4-(2-aminoethyl)piperazin-1-yl]acetyl]amino]-3,3-dimethyl-butanoyl]-4-hydroxy-N-[[4-(4-methylthiazol-5-yl)phenyl]methyl]pyrrolidine-2-carboxamide (90 mg, 126.91 μmol, 3HCl salt), 8-(3,5-difluoro-2-pyridyl)-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxylic acid (63.51 mg, 126.91 μmol) and DIEA (98.41 mg, 761.45 μmol, 132.63 μL) in DMF (1 mL) were added HOBt (25.72 mg, 190.36 μmol), EDCI (36.49 mg, 190.36 μmol) at 0° C. under N₂. The mixture warmed to 25° C. and stirred for 2 hours. The reaction mixture was diluted with water (3 mL) and extracted with Dichloromethane/Methanol (10/1, 5 mL×3). The combined organic phase was washed with brine (5 mL), dried with anhydrous Na₂SO₄, filtered and concentrated in vacuo. The residue was purified by preparative PLC (column: Welch Ultimate C18 150*25 mm*5 um; mobile phase: [water (FA)-ACN]; gradient: 14%-44% B over 10 min) to afford the desired product 8-(3,5-difluoro-2-pyridyl)-N-[2-[4-[2-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-2-oxo-ethyl]piperazin-1-yl]ethyl]-15-methyl-4-(methylsulfonylmethyl)-14-oxo-8,12,15-triazatetracyclo[8.6.1.02,7.013,17]heptadeca-1(16),2(7),3,5,10,13(17)-hexaene-5-carboxamide (15.68 mg, 14.17 μmol, 11.17% yield, 97.829% purity) as a white solid. ¹H NMR: DMSO-d₆, 400 MHz. δ 11.91 (s, 1H), 8.96 (s, 1H), 8.66-8.51 (m, 1H), 8.36-8.22 (m, 1H), 8.09-8.05 (m, 1H), 7.92 (s, 1H), 7.80-7.54 (m, 3H), 7.45-7.37 (m, 4H), 7.33-7.19 (m, 2H), 6.05-4.91 (m, 2H), 4.73-4.19 (m, 7H), 3.72-3.42 (m, 6H), 3.08-2.81 (m, 6H), 2.46-2.34 (m, 14H), 2.08-1.88 (m, 2H), 0.94 (s, 9H). LCMS: RT=1.984 min, m/z 1082.7 [M+H]⁺.

### Example C-22. Synthesis of (2S,4R)-1-[(2S)-2-[[2-[2-[2-[2-[[4-[(2S,4R)-1-acetyl-4-(4-chloroanilino)-2-methyl-3,4-dihydro-2H-quinolin-6-yl]benzoyl]amino]ethoxy]ethoxy]ethoxy]acetyl]amino]-3,3-dimethyl-butanoyl]-4-hydroxy-N-[(1S)-1-[4-(4-methylthiazol-5-yl)phenyl]ethyl]pyrrolidine-2-carboxamide

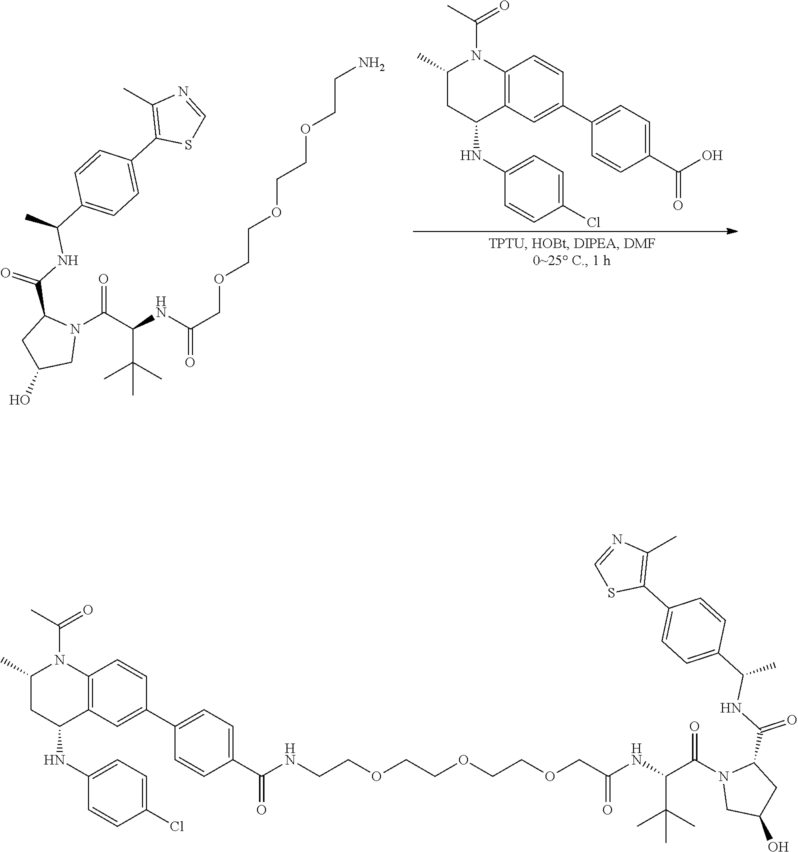 [SMILES: Cc1ncsc1-c1ccc([C@H](C)NC(=O)[C@@H]2C[C@@H](O)CN2C(=O)[C@@H](NC(=O)COCCOCCOCCN)C(C)(C)C)cc1 ; CC(=O)N1c2ccc(-c3ccc(C(=O)O)cc3)cc2[C@H](Nc2ccc(Cl)cc2)C[C@@H]1C ; CC(=O)N1c2ccc(-c3ccc(C(=O)NCCOCCOCCOCC(=O)N[C@H](C(=O)N4C[C@H](O)C[C@H]4C(=O)N[C@@H](C)c4ccc(-c5scnc5C)cc4)C(C)(C)C)cc3)cc2[C@H](Nc2ccc(Cl)cc2)C[C@@H]1C]

To a mixture of (2S,4R)-1-[(2S)-2-[[2-[2-[2-(2-aminoethoxy)ethoxy]ethoxy]acetyl]amino]-3,3-dimethyl-butanoyl]-4-hydroxy-N-[(1S)-1-[4-(4-methylthiazol-5-yl)phenyl]ethyl]pyrrolidine-2-carboxamide (100 mg, 149.20 μmol, HCl salt), 4-[(2S,4R)-1-acetyl-4-(4-chloroanilino)-2-methyl-3,4-dihydro-2H-quinolin-6-yl]benzoic acid (54.07 mg, 124.33 μmol) in DMF (1 mL) were added DIPEA (96.41 mg, 745.98 μmol, 129.94 μL), HOBt (25.20 mg, 186.50 μmol) and TPTU (55.40 mg, 186.50 μmol) at 0° C. Then the mixture was warmed to 25° C. and stirred for 1 hour. The mixture was diluted with water (15 mL) and extracted with ethyl acetate (10 mL×3). The combined organic phase was dried over anhydrous Na₂SO₄, filtered and concentrated in vacuo. The residue was purified by preparative HPLC (column: Phenomenex luna C18 150*25 mm*10 um; mobile phase: [water (FA)-ACN]; gradient: 40%-70% B over 10 min) to afford the desired product (2S,4R)-1-[(2S)-2-[[2-[2-[2-[2-[[4-[(2S,4R)-1-acetyl-4-(4-chloroanilino)-2-methyl-3,4-dihydro-2H-quinolin-6-yl]benzoyl]amino]ethoxy]ethoxy]ethoxy]acetyl]amino]-3,3-dimethyl-butanoyl]-4-hydroxy-N-[(1S)-1-[4-(4-methylthiazol-5-yl)phenyl]ethyl]pyrrolidine-2-carboxamide (50.57 mg, 48.03 [mol, 38.63% yield, 99.8% purity) as a white solid. ¹H NMR: DMSO-d₆, 400 MHz. δ 8.98 (s, 1H), 8.57-8.49 (m, 1H), 8.44 (d, J=8.0 Hz, 1H), 7.93-7.87 (m, 2H), 7.64-7.58 (m, 3H), 7.47-7.38 (m, 5H), 7.37-7.33 (m, 2H), 7.15-7.09 (m, 2H), 6.77-6.71 (m, 2H), 6.29 (d, J=8.0 Hz, 1H), 5.13 (d, J=3.6 Hz, 1H), 4.94-4.84 (m, 1H), 4.76-4.64 (m, 1H), 4.54 (d, J=9.6 Hz, 1H), 4.44 (t, J=8.0 Hz, 1H), 4.35-4.25 (m, 2H), 3.97-3.90 (m, 2H), 3.60-3.52 (m, 12H), 3.45-3.42 (m, 2H), 2.64-2.57 (m, 2H), 2.44 (s, 3H), 2.14 (s, 3H), 2.09-2.00 (m, 1H), 1.82-1.71 (m, 1H), 1.35 (d, J=6.8 Hz, 3H), 1.09 (d, J=6.4 Hz, 3H), 0.92 (s, 9H). LCMS: RT=2.498 min, m/z 1051.6 [M+H]⁺.

### Example C-23. Synthesis of (2S,4R)-1-[(2S)-2-[5-[4-[2-[[4-[(2S,4R)-1-acetyl-4-(4-chloroanilino)-2-methyl-3,4-dihydro-2H-quinolin-6-yl]benzoyl]amino]ethyl]piperazin-1-yl]pentanoylamino]-3,3-dimethyl-butanoyl]-4-hydroxy-N-[[4-(4-methylthiazol-5-yl)phenyl]methyl]pyrrolidine-2-carboxamide

### A. Step 1

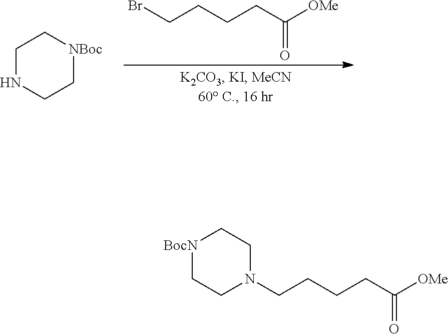 [SMILES: CC(C)(C)OC(=O)N1CCNCC1 ; COC(=O)CCCCBr ; COC(=O)CCCCN1CCN(C(=O)OC(C)(C)C)CC1]

A mixture of tert-butyl piperazine-1-carboxylate (5.0 g, 26.85 mmol) methyl 5-bromopentanoate (6.28 g, 32.21 mmol, 4.61 mL), K₂CO₃ (11.13 g, 80.54 mmol) and KI (4.46 g, 26.85 mmol) in MeCN (50 mL) was heated to 60° C. and stirred for 16 hours under N₂. The reaction mixture was diluted with water (50 mL). The mixture was extracted with Dichloromethane/Methanol (10/1, 60 mL×3). The combined organic phase was washed with brine (80 mL), dried with anhydrous Na₂SO₄, filtered and concentrated in vacuo. The residue was purified by column chromatography on silica gel (Petroleum ether/Ethyl acetate=1/1) to afford the desired product tert-butyl 4-(5-methoxy-5-oxo-pentyl)piperazine-1-carboxylate (8.0 g, 26.63 mmol, 99.20% yield) as a colorless oil. ¹H NMR: DMSO-d₆, 400 MHz. δ 3.58 (s, 3H), 3.30-3.26 (m, 4H), 2.31 (t, J=7.2 Hz, 2H), 2.28-2.23 (m, 6H), 1.56-1.49 (m, 2H), 1.45-1.40 (m, 2H), 1.39 (s, 9H).

### B. Step 2

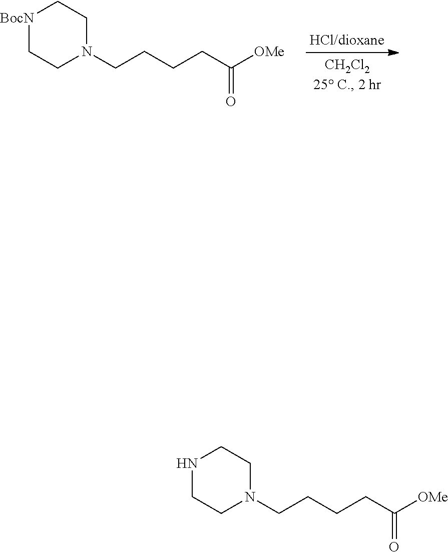 [SMILES: COC(=O)CCCCN1CCN(C(=O)OC(C)(C)C)CC1 ; COC(=O)CCCCN1CCNCC1]

To a solution of tert-butyl 4-(5-methoxy-5-oxo-pentyl)piperazine-1-carboxylate (4 g, 13.32 mmol,) in CH₂Cl₂ (30 mL) was added HCl/dioxane (4 M in dioxane, 40.0 mmol, 10 mL) at 25° C. The mixture was stirred at 25° C. for 2 hours under N₂. The reaction mixture was concentrated in vacuo to afford the desired product methyl 5-piperazin-1-ylpentanoate (3 g, 12.67 mmol, 95.17% yield, 2 HCl salt) as a white solid. ¹H NMR: DMSO-d₆, 400 MHz. δ 11.71 (brs, 1H), 9.73 (brs, 2H), 3.72-7.69 (m, 1H), 3.60 (s, 3H), 3.54-3.42 (m, 4H), 3.31-3.03 (m, 4H), 2.36 (t, J=7.2 Hz, 2H), 1.76-1.64 (m, 2H), 1.62-1.50 (m, 2H).

### C. Step 3

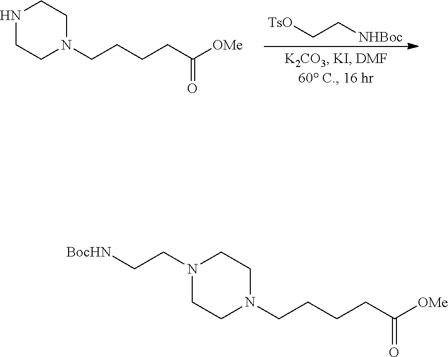 [SMILES: COC(=O)CCCCN1CCNCC1 ; Cc1ccc(S(=O)(=O)OCCNC(=O)OC(C)(C)C)cc1 ; COC(=O)CCCCN1CCN(CCNC(=O)OC(C)(C)C)CC1]

A mixture of methyl 5-piperazin-1-ylpentanoate (3 g, 12.67 mmol, 2 HCl salt) 2-(tert-butoxycarbonylamino)ethyl 4-methylbenzenesulfonate (4.80 g, 15.21 mmol), K₂CO₃ (5.25 g, 38.02 mmol) and KI (2.10 g, 12.67 mmol) in DMF (30 mL) was heated to 60° C. and stirred for 16 hours under N₂. The reaction mixture was diluted with water (30 mL). The mixture was extracted with Dichloromethane/Methanol (10/1, 40 mL×3). The combined organic phase was washed with brine (50 mL), dried with anhydrous Na₂SO₄, filtered and concentrated in vacuo.

The residue was purified by column chromatography on silica gel (Dichloromethane/Methanol=40/1) to afford the desired product methyl 5-[4-[2-(tert-butoxycarbonylamino)ethyl]piperazin-1-yl]pentanoate (2.4 g, 6.99 mmol, 55.14% yield) as a yellow oil. ¹H NMR: DMSO-d₆, 400 MHz. δ 6.67-6.53 (m, 1H), 3.58 (s, 3H), 3.04-2.97 (m, 2H), 2.36-2.23 (m, 12H), 1.56-1.39 (m, 6H), 1.37 (s, 9H).

### D. D. Step 4

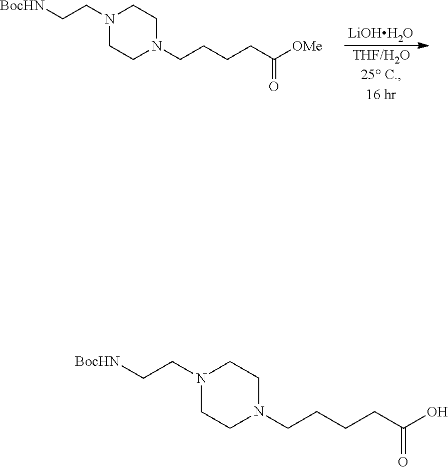 [SMILES: COC(=O)CCCCN1CCN(CCNC(=O)OC(C)(C)C)CC1 ; "LiOH·H2O" ; "THF/H2O25° C.,16 hr" ; CC(C)(C)OC(=O)NCCN1CCN(CCCCC(=O)O)CC1]

A mixture of methyl 5-[4-[2-(tert-butoxycarbonylamino)ethyl]piperazin-1-yl]pentanoate (2.4 g, 6.99 mmol) and LiOH H₂O (879.61 mg, 20.96 mmol) in THE (25 mL) and H₂O (5 mL) was stirred at 25° C. for 16 hours under N₂. The pH of the mixture was adjusted to 6 by addition of 2 N aqueous HCl solution. The reaction mixture was diluted with water (30 mL).

The mixture was extracted with Dichloromethane/Methanol (10/1, 40 mL×3). The combined organic phase was washed with brine (50 mL), dried with anhydrous Na₂SO₄, filtered and concentrated in vacuo. The residue was purified by preparative HPLC (column: YMC Triart C18 70*250 mm*7 um; mobile phase: [water (NH₄HCO₃)-ACN]; gradient: 0%-30% B over 20 min) to afford the desired product 5-[4-[2-(tert-butoxycarbonylamino)ethyl]piperazin-1-yl]pentanoic acid (1.95 g, 5.92 mmol, 84.71% yield) as a yellow oil. ¹H NMR: DMSO-d₆, 400 MHz. δ 6.65-6.55 (m, 1H), 3.03-2.98 (m, 2H), 2.37-2.17 (m, 14H), 1.52-1.39 (m, 4H), 1.37 (s, 9H).

### E. E. Step 5

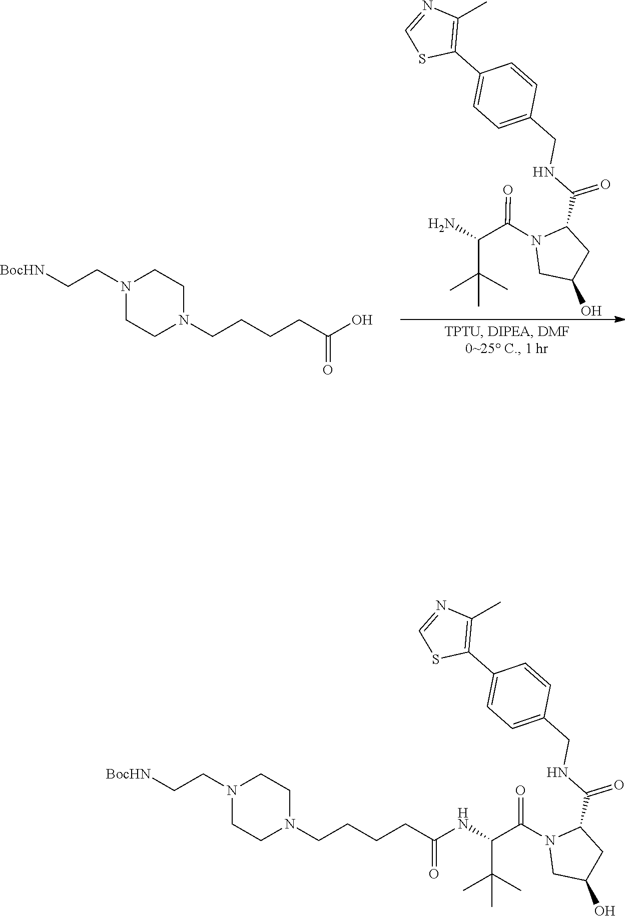 [SMILES: CC(C)(C)OC(=O)NCCN1CCN(CCCCC(=O)O)CC1 ; Cc1ncsc1-c1ccc(CNC(=O)[C@@H]2C[C@@H](O)CN2C(=O)[C@@H](N)C(C)(C)C)cc1 ; Cc1ncsc1-c1ccc(CNC(=O)[C@@H]2C[C@@H](O)CN2C(=O)[C@@H](NC(=O)CCCCN2CCN(CCNC(=O)OC(C)(C)C)CC2)C(C)(C)C)cc1]

To a mixture of 5-[4-[2-(tert-butoxycarbonylamino)ethyl]piperazin-1-yl]pentanoic acid (84.65 mg, 256.95 μmol), (2S,4R)-1-[(2S)-2-amino-3,3-dimethyl-butanoyl]-4-hydroxy-N-[[4-(4-methylthiazol-5-yl)phenyl]methyl]pyrrolidine-2-carboxamide (120 mg, 256.95 μmol, HCl salt) in DMF (1 mL) was added DIPEA (199.25 mg, 1.54 mmol, 268.53 uL) and TBTU (123.75 mg, 385.42 μmol) at 0° C. The mixture was warmed to 25° C. and stirred for 0 hour under N₂. The reaction mixture was diluted with water (2 mL). The mixture was extracted with Dichloromethane/Methanol (10/1, 3 mL×3). The combined organic phase was washed with brine (4 mL), dried with anhydrous Na₂SO₄, filtered and concentrated in vacuo. The residue was purified by preparative TLC on silica gel (Dichloromethane/Methanol=5/1) to afford the desired product tert-butyl N-[2-[4-[5-[[(1S)-1-[(2S,4R)-4-hydroxy-2-[[4-(4-methylthiazol-5-yl)phenyl]methylcarbamoyl]pyrrolidine-1-carbonyl]-2,2-dimethylpropyl]amino]-5-oxo-pentyl]piperazin-1-yl]ethyl]carbamate (120 mg, 150.89 μmol, 58.73% yield, 93.3% purity) as a colorless oil. LCMS. RT=0.327 min, m/z 742.4 [M+H]⁺.

### F. E Step 6

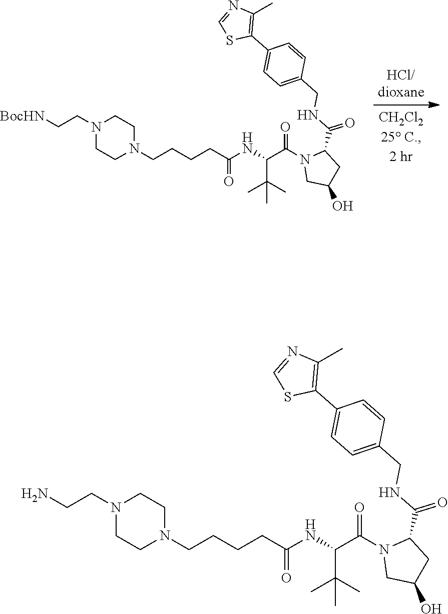 [SMILES: Cc1ncsc1-c1ccc(CNC(=O)[C@@H]2C[C@@H](O)CN2C(=O)[C@@H](NC(=O)CCCCN2CCN(CCNC(=O)OC(C)(C)C)CC2)C(C)(C)C)cc1 ; Cc1ncsc1-c1ccc(CNC(=O)[C@@H]2C[C@@H](O)CN2C(=O)[C@@H](NC(=O)CCCCN2CCN(CCN)CC2)C(C)(C)C)cc1]

To a solution of tert-butyl N-[2-[4-[5-[[(1S)-1-[(2S,4R)-4-hydroxy-2-[[4-(4-methylthiazol-5-yl)phenyl]methylcarbamoyl]pyrrolidine-1-carbonyl]-2,2-dimethyl-propyl]amino]-5-oxo-pentyl]piperazin-1-yl]ethyl]carbamate (120 mg, 161.73 μmol) in CH₂Cl₂ (1 mL) was added HCl/dioxane (2 M in dioxane, 2.0 mmol, 1 mL) at 25° C. and stirred for 1 hour under N₂. The reaction mixture was filtered and concentrated in vacuo to afford the desired product (2S,4R)-1-[(2S)-2-[5-[4-(2-aminoethyl)piperazin-1-yl]pentanoylamino]-3,3-dimethyl-butanoyl]-4-hydroxy-N-[[4-(4-methylthiazol-5-yl)phenyl]methyl]pyrrolidine-2-carboxamide (120 mg, 154.94 μmol, 95.80% yield, 97% purity, 3HCl salt). LCMS: RT=0.258 min, m/z 642.3 [M+H]⁺.

### G. Step 7

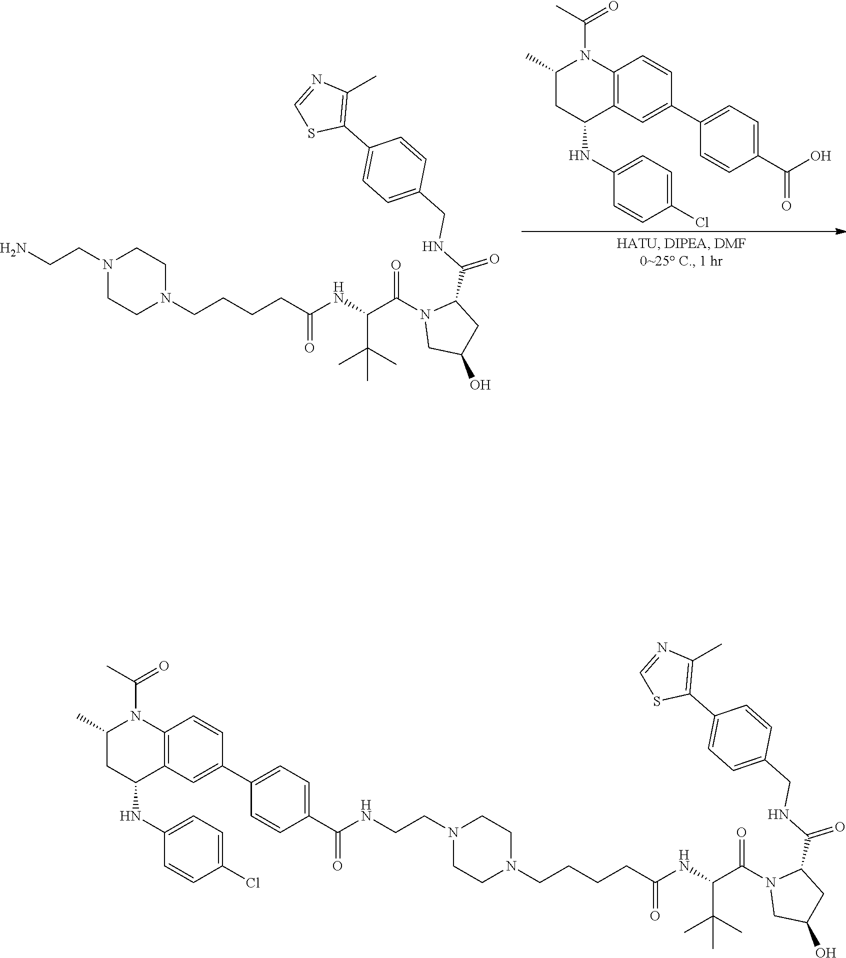 [SMILES: Cc1ncsc1-c1ccc(CNC(=O)[C@@H]2C[C@@H](O)CN2C(=O)[C@@H](NC(=O)CCCCN2CCN(CCN)CC2)C(C)(C)C)cc1 ; CC(=O)N1c2ccc(-c3ccc(C(=O)O)cc3)cc2[C@H](Nc2ccc(Cl)cc2)C[C@@H]1C ; CC(=O)N1c2ccc(-c3ccc(C(=O)NCCN4CCN(CCCCC(=O)N[C@H](C(=O)N5C[C@H](O)C[C@H]5C(=O)NCc5ccc(-c6scnc6C)cc5)C(C)(C)C)CC4)cc3)cc2[C@H](Nc2ccc(Cl)cc2)C[C@@H]1C]

To a mixture of (2S,4R)-1-[(2S)-2-[5-[4-(2-aminoethyl)piperazin-1-yl]pentanoylamino]-3,3-dimethyl-butanoyl]-4-hydroxy-N-[[4-(4-methylthiazol-5-yl)phenyl]methyl]pyrrolidine-2-carboxamide (100 mg, 133.11 μmol, 3HCl salt), 4-[(2S,4R)-1-acetyl-4-(4-chloroanilino)-2-methyl-3,4-dihydro-2H-quinolin-6-yl]benzoic acid (57.89 mg, 133.11 μmol) in DMF (1 mL) were added DIPEA (103.22 mg, 798.67 μmol, 139.11 uL) and HATU (75.92 mg, 199.67 μmol) at 0° C. The mixture was warmed to 25° C. and stirred for 1 hour under N₂. The reaction mixture was diluted with water (2 mL). The mixture was extracted with Dichloromethane/Methanol (10/1, 3 mL×3). The combined organic phase was washed with brine (4 mL), dried with anhydrous Na₂SO₄, filtered and concentrated in vacuo. The residue was purified by preparative HPLC (column: Phenomenex luna C18 150*25 mm*10 um; mobile phase: [water (FA)-ACN]; gradient: 20%-50% B over 10 min) to afford the desired product (2S,4R)-1-[(2S)-2-[5-[4-[2-[[4-[(2S,4R)-1-acetyl-4-(4-chloroanilino)-2-methyl-3,4-dihydro-2H-quinolin-6-yl]benzoyl]amino]ethyl]piperazin-1-yl]pentanoylamino]-3,3-dimethyl-butanoyl]-4-hydroxy-N-[[4-(4-methylthiazol-5-yl)phenyl]methyl]pyrrolidine-2-carboxamide (58.14 mg, 54.69 μmol, 41.09% yield, 99.6% purity) as a white solid. ¹H NMR: DMSO-d₆, 400 MHz. δ 8.98 (s, 1H), 8.57-8.52 (m, 1H), 8.42-8.36 (m, 1H), 8.14 (s, 1H), 7.90-7.81 (m, 3H), 7.65-7.58 (m, 3H), 7.46-7.36 (m, 6H), 7.15-7.10 (m, 2H), 6.78-6.71 (m, 2H), 6.31-6.25 (m, 1H), 5.29-4.93 (m, 1H), 4.78-4.64 (m, 1H), 4.57-4.51 (m, 1H), 4.47-4.39 (m, 2H), 4.37-4.18 (m, 3H), 3.71-3.60 (m, 2H), 3.40-3.36 (m, 4H), 2.65-2.59 (m, 1H), 2.46 (s, 9H), 2.35-2.22 (m, 4H), 2.14 (s, 3H), 2.13-1.98 (m, 2H), 1.94-1.87 (m, 1H), 1.53-1.37 (m, 4H), 1.28-1.18 (m, 1H), 1.17-1.07 (m, 3H), 0.93 (s, 9H). LCMS: RT=2.191 min, m/z 1058.7 [M+H]⁺.

### Example C-24. Synthesis of (2S,4R)-1-[(2S)-2-[[2-[4-[[1-[2-[[4-[(2S,4R)-1-acetyl-4-(4-chloroanilino)-2-methyl-3,4-dihydro-2H-quinolin-6-yl]benzoyl]amino]ethyl]-4-piperidyl]methyl]piperazin-1-yl]acetyl]amino]-3,3-dimethyl-butanoyl]-4-hydroxy-N-[[4-(4-methylthiazol-5-yl)phenyl]methyl]pyrrolidine-2-carboxamide

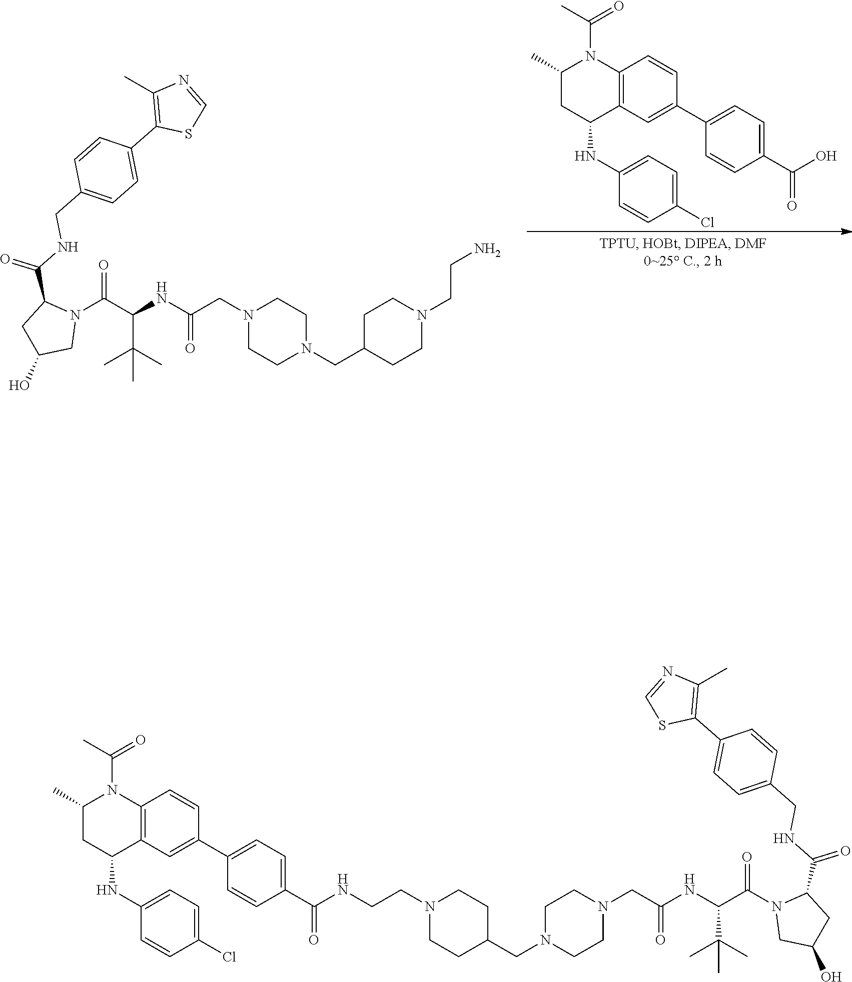 [SMILES: Cc1ncsc1-c1ccc(CNC(=O)[C@@H]2C[C@@H](O)CN2C(=O)[C@@H](NC(=O)CN2CCN(CC3CCN(CCN)CC3)CC2)C(C)(C)C)cc1 ; CC(=O)N1c2ccc(-c3ccc(C(=O)O)cc3)cc2[C@H](Nc2ccc(Cl)cc2)C[C@@H]1C ; CC(=O)N1c2ccc(-c3ccc(C(=O)NCCN4CCC(CN5CCN(CC(=O)N[C@H](C(=O)N6C[C@H](O)C[C@H]6C(=O)NCc6ccc(-c7scnc7C)cc6)C(C)(C)C)CC5)CC4)cc3)cc2[C@H](Nc2ccc(Cl)cc2)C[C@@H]1C]

To a solution of (2S,4R)-1-[(2S)-2-[[2-[4-[[1-(2-aminoethyl)-4-piperidyl]methyl]piperazin-1-yl]acetyl]amino]-3,3-dimethyl-butanoyl]-4-hydroxy-N-[[4-(4-methylthiazol-5-yl)phenyl]methyl]pyrrolidine-2-carboxamide (105.06 mg, 103.47 μmol, 4HCl salt), 4-[(2S,4R)-1-acetyl-4-(4-chloroanilino)-2-methyl-3,4-dihydro-2H-quinolin-6-yl]benzoic acid (45 mg, 103.47 μmol) and DIPEA (80.24 mg, 620.81 μmol, 108.13 μL) in DMF (1 mL) were added TPTU (46.10 mg, 155.20 μmol) and HOBt (20.97 mg, 155.20 μmol) at 0° C. under N₂. The mixture was warmed to 25° C. and stirred for 2 hours under N₂. The reaction mixture was diluted with water (3 mL) and extracted with Dichloromethane/Methanol (10/1, 3 mL×3).

The combined organic phase was washed with brine (3 mL), dried with anhydrous Na₂SO₄, filtered and concentrated in vacuo. The residue was purified by preparative HPLC(column: Phenomenex luna C18 150*25 mm*10 um; mobile phase: [water (FA)-ACN]; gradient: 14%-44% B over 10 min) to afford the desired product (2S,4R)-1-[(2S)-2-[[2-[4-[[1-[2-[[4-[(2S,4R)-1-acetyl-4-(4-chloroanilino)-2-methyl-3,4-dihydro-2H-quinolin-6-yl]benzoyl]amino]ethyl]-4-piperidyl]methyl]piperazin-1-yl]acetyl]amino]-3,3-dimethyl-butanoyl]-4-hydroxy-N-[[4-(4-methylthiazol-5-yl)phenyl]methyl]pyrrolidine-2-carboxamide (50.01 mg, 44.45 μmol, 42.96% yield, 99% purity) as a white solid. ¹H NMR: DMSO-d₆, 400 MHz. δ 8.98 (s, 1H), 8.65-8.57 (m, 1H), 8.40-8.38 (m, 1H), 8.17 (s, 1H), 7.88-7.86 (m, 2H), 7.79-7.77 (m, 1H), 7.62-7.60 (m, 2H), 7.46-7.38 (m, 6H), 7.13-7.11 (m, 2H), 6.75-6.72 (m, 2H), 6.30-6.28 (m, 1H), 5.27-5.03 (m, 1H), 4.77-4.66 (m, 1H), 4.49-4.25 (m, 6H), 3.70-3.55 (m, 4H), 3.05-2.99 (m, 2H), 2.93-2.91 (m, 1H), 2.89-2.85 (m, 2H), 2.65-2.57 (m, 2H), 2.45 (s, 2H), 2.44 (s, 3H), 2.43-2.34 (m, 4H), 2.14 (s, 3H), 2.12-1.98 (m, 4H), 1.98-1.72 (m, 4H), 1.64-1.58 (m, 2H), 1.49-1.41 (m, 1H), 1.26-1.21 (m, 1H), 1.10-1.08 (m, 3H), 1.05-1.04 (m, 2H), 0.93 (s, 9H). LCMS: RT=2.095 min, m/z 1113.8 [M+H]⁺.

### Example C-25. Synthesis of (2S,4R)-1-[(2S)-2-[[2-[4-[1-[2-[[4-[(2S,4R)-1-acetyl-4-(4-chloroanilino)-2-methyl-3,4-dihydro-2H-quinolin-6-yl]benzoyl]amino]ethyl]azetidin-3-yl]piperazin-1-yl]acetyl]amino]-3,3-dimethyl-butanoyl]-4-hydroxy-N-[[4-(4-methylthiazol-5-yl)phenyl]methyl]pyrrolidine-2-carboxamide

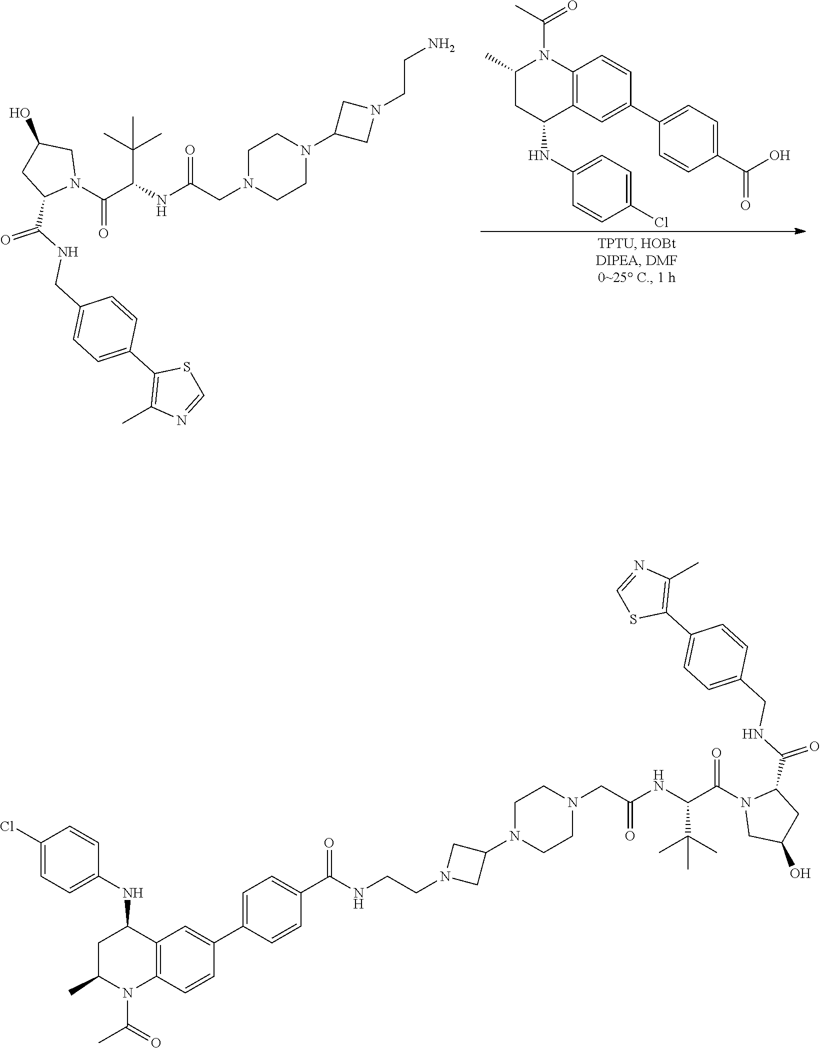 [SMILES: Cc1ncsc1-c1ccc(CNC(=O)[C@@H]2C[C@@H](O)CN2C(=O)[C@@H](NC(=O)CN2CCN(C3CN(CCN)C3)CC2)C(C)(C)C)cc1 ; CC(=O)N1c2ccc(-c3ccc(C(=O)O)cc3)cc2[C@H](Nc2ccc(Cl)cc2)C[C@@H]1C ; CC(=O)N1c2ccc(-c3ccc(C(=O)NCCN4CC(N5CCN(CC(=O)N[C@H](C(=O)N6C[C@H](O)C[C@H]6C(=O)NCc6ccc(-c7scnc7C)cc6)C(C)(C)C)CC5)C4)cc3)cc2[C@H](Nc2ccc(Cl)cc2)C[C@@H]1C]

To a mixture of (2S,4R)-1-[(2S)-2-[[2-[4-[1-(2-aminoethyl)azetidin-3-yl]piperazin-1-yl]acetyl]amino]-3,3-dimethyl-butanoyl]-4-hydroxy-N-[[4-(4-methylthiazol-5-yl)phenyl]methyl]pyrrolidine-2-carboxamide (110.46 mg, 137.96 μmol, 4HCl salt), 4-[(2S,4R)-1-acetyl-4-(4-chloroanilino)-2-methyl-3,4-dihydro-2H-quinolin-6-yl]benzoic acid (60 mg, 137.96 mol) and DIPEA (106.98 mg, 827.75 μmol, 144.18 μL) in DMF (2 mL) were added TPTU (61.47 mg, 206.94 μmol) and HOBt (27.96 mg, 206.94 μmol) at 0′° C. The mixture was stirred to 25° C. for 1 hour under N₂. The reaction mixture was diluted with water (2 mL) and extracted with Dichloromethane/Methanol (10/1, 3 mL×3). The combined organic phase was washed with brine (3 mL), dried with anhydrous Na₂SO₄, filtered and concentrated in vacuo. The residue was purified by preparative HPLC (column: Phenomenex luna C18 150*25 mm*110 um; mobile phase: [water (FA)-ACN]; gradient: 19%-49% B over 10 min) to afford the desired product (2S,4R)-1-[(2S)-2-[[2-[4-[1-[2-[[4-[(2S,4R)-1-acetyl-4-(4-chloroanilino)-2-methyl-3,4-dihydro-2H-quinolin-6-yl]benzoyl]amino]ethyl]azetidin-3-yl]piperazin-1-yl]acetyl]amino]-3,3-dimethyl-butanoyl]-4-hydroxy-N-[[4-(4-methylthiazol-5-yl)phenyl]methyl]pyrrolidine-2-carboxamide (26.35 mg, 24.34 nmol, 17.64% yield, 99% purity) as a white solid. TH NMR: DMSO-d₆, 400 MHz. δ 8.98 (s, 1H), 8.66-8.56 (m, 1H), 8.46-8.36 (m, 1H), 8.20 (s, 1H), 7.92-7.85 (m, 2H), 7.77-7.70 (m, 1H), 7.64-7.57 (m, 3H), 7.46-7.43 (m, 2H), 7.41-7.40 (m, 3H), 7.16-7.09 (m, 2H), 6.77-6.70 (m, 2H), 6.32-6.25 (m, 1H), 5.18-5.09 (m, 1H), 4.65-4.29 (m, 8H), 3.65-3.59 (m, 6H), 3.15-3.00 (m, 8H), 2.94-2.89 (m, 2H), 2.82-2.77 (m, 4H), 2.44 (s, 3H), 2.29-2.24 (m, 2H), 2.14 (s, 3H), 2.05-1.91 (m, 2H), 1.11-1.07 (m, 3H), 0.92 (s, 9H). LCMS: RT=2.085 min, m/z 1071.7 [M+H]⁺.

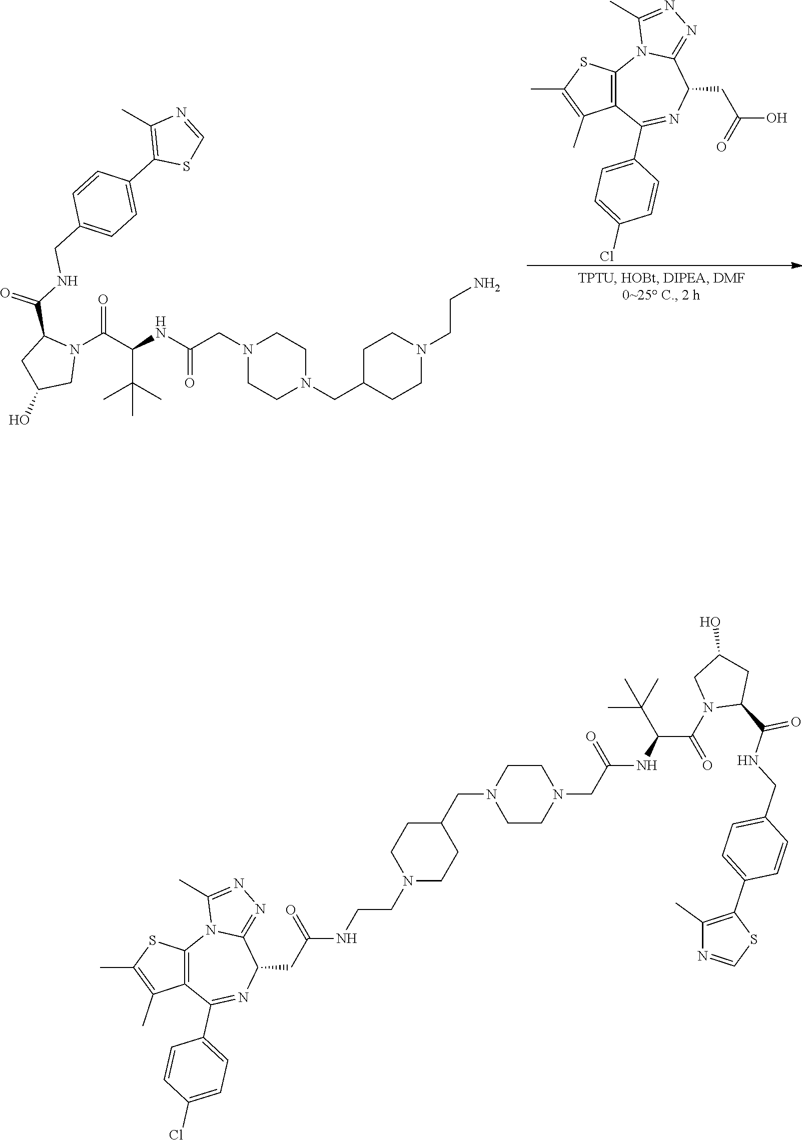 [SMILES: Cc1ncsc1-c1ccc(CNC(=O)[C@@H]2C[C@@H](O)CN2C(=O)[C@@H](NC(=O)CN2CCN(CC3CCN(CCN)CC3)CC2)C(C)(C)C)cc1 ; Cc1sc2c(c1C)C(c1ccc(Cl)cc1)=N[C@@H](CC(=O)O)c1nnc(C)n1-2 ; Cc1ncsc1-c1ccc(CNC(=O)[C@@H]2C[C@@H](O)CN2C(=O)[C@@H](NC(=O)CN2CCN(CC3CCN(CCNC(=O)C[C@@H]4N=C(c5ccc(Cl)cc5)c5c(sc(C)c5C)-n5c(C)nnc54)CC3)CC2)C(C)(C)C)cc1]

### Example C-26. Synthesis of (2S,4R)-1-[(2S)-2-[[2-[4-[[1-[2-[[2-[(9S)-7-(4-chlorophenyl)-4,5,13-trimethyl-3-thia-1,8,11,12-tetrazatricyclo[8.3.0.02,6]trideca-2(6),4,7,10,12-pentaen-9-yl]acetyl]amino]ethyl]-4-piperidyl]methyl]piperazin-1-yl]acetyl]amino]-3,3-dimethyl-butanoyl]-4-hydroxy-N-[[4-(4-methylthiazol-5-yl)phenyl]methyl]pyrrolidine-2-carboxamide

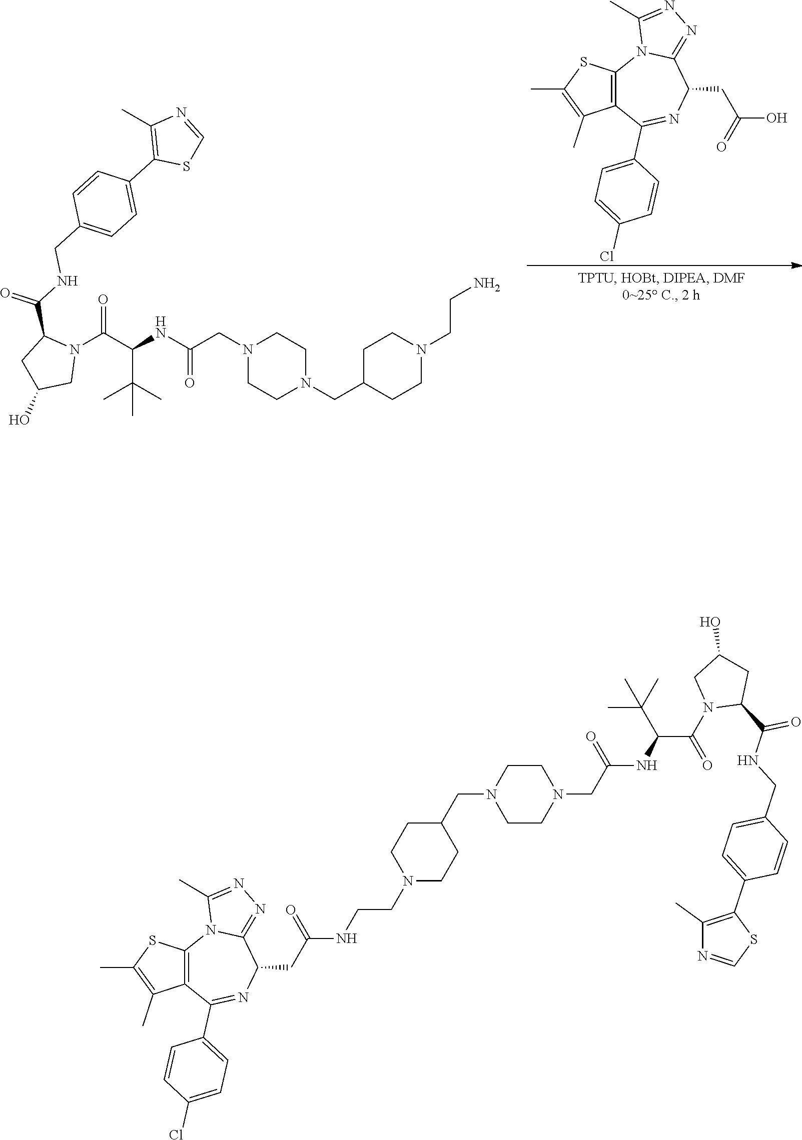 [SMILES: Cc1ncsc1-c1ccc(CNC(=O)[C@@H]2C[C@@H](O)CN2C(=O)[C@@H](NC(=O)CN2CCN(CC3CCN(CCN)CC3)CC2)C(C)(C)C)cc1 ; Cc1sc2c(c1C)C(c1ccc(Cl)cc1)=N[C@@H](CC(=O)O)c1nnc(C)n1-2 ; Cc1ncsc1-c1ccc(CNC(=O)[C@@H]2C[C@@H](O)CN2C(=O)[C@@H](NC(=O)CN2CCN(CC3CCN(CCNC(=O)C[C@@H]4N=C(c5ccc(Cl)cc5)c5c(sc(C)c5C)-n5c(C)nnc54)CC3)CC2)C(C)(C)C)cc1]

To a solution of (2S,4R)-1-[(2S)-2-[[2-[4-[[1-(2-aminoethyl)-4-piperidyl]methyl]piperazin-1-yl]acetyl]amino]-3,3-dimethyl-butanoyl]-4-hydroxy-N-[[4-(4-methylthiazol-5-yl)phenyl]methyl]pyrrolidine-2-carboxamide (113.98 mg, 112.25 μmol, 4HCl salt), 2-[(9S)-7-(4-chlorophenyl)-4,5,13-trimethyl-3-thia-1,8,11,12-tetrazatricyclo[8.3.0.02,6]trideca-2(6),4,7,10,12-pentaen-9-yl]acetic acid (45 mg, 112.25 μmol) and DIPEA (87.05 mg, 673.52 μmol, 117.31 μL) in DMF (1 mL) were added HOBt (22.75 mg, 168.38 μmol) and TPTU (50.02 mg, 168.38 μmol) at 0° C. under N₂. The mixture was warmed to 25° C. and stirred for 2 hours under N₂. The reaction mixture was diluted with water (3 mL) and extracted with Dichloromethane/Methanol (10/1, 3 mL×3). The combined organic phase was washed with brine (3 mL), dried with anhydrous Na₂SO₄, filtered and concentrated in vacuo. The residue was purified by preparative HPLC(column: Phenomenex luna C18 150*25 mm*10 um; mobile phase: [water (FA)-ACN]; gradient: 11%-41% B over 10 min) to afford the desired product (2S,4R)-1-[(2S)-2-[[2-[4-[[1-[2-[[2-[(9S)-7-(4-chlorophenyl)-4,5,13-trimethyl-3-thia-1,8,11,12-tetrazatricyclo[8.3.0.02,6]trideca-2(6),4,7,10,12-pentaen-9-yl]acetyl]amino]ethyl]-4-piperidyl]methyl]piperazin-1-yl]acetyl]amino]-3,3-dimethyl-butanoyl]-4-hydroxy-N-[[4-(4-methylthiazol-5-yl)phenyl]methyl]pyrrolidine-2-carboxamide (50.61 mg, 46.87 μmol, 41.75% yield, 100% purity) as a white solid. ¹H NMR: 400 MHz. δ 8.98 (s, 1H), 8.62-8.59 (m, 1H), 8.13 (m, 2H), 7.80-7.77 (m, 1H), 7.47 (s, 1H), 7.45-7.38 (m, 6H), 5.35-4.97 (m, 1H), 4.54-4.47 (m, 2H), 4.45-4.33 (m, 3H), 4.28-4.23 (m, 1H), 3.67-3.59 (m, 4H), 3.24-3.15 (m, 8H), 3.05-2.99 (m, 2H), 2.93-2.84 (m, 3H), 2.59 (s, 3H), 2.44 (s, 3H), 2.41 (s, 3H), 2.34-2.30 (m, 4H), 2.11-1.90 (m, 6H), 1.62 (s, 3H), 1.60-1.57 (m, 1H), 1.49-1.40 (m, 1H), 1.12-1.01 (m, 2H), 0.93 (s, 9H). LCMS: RT=2.061 min, m/z 1079.7 [M+H]⁺.

### Example C-27. Synthesis of (2S,4R)-1-[(2S)-2-[[2-[4-[1-[2-[[2-[(9S)-7-(4-chlorophenyl)-4,5,13-trimethyl-3-thia-1,8,11,12-tetrazatricyclo[8.3.0.02,6]trideca-2(6),4,7,10,12-pentaen-9-yl]acetyl]amino]ethyl]azetidin-3-yl]piperazin-1-yl]acetyl]amino]-3,3-dimethyl-butanoyl]-4-hydroxy-N-[[4-(4-methylthiazol-5-yl)phenyl]methyl]pyrrolidine-2-carboxamide

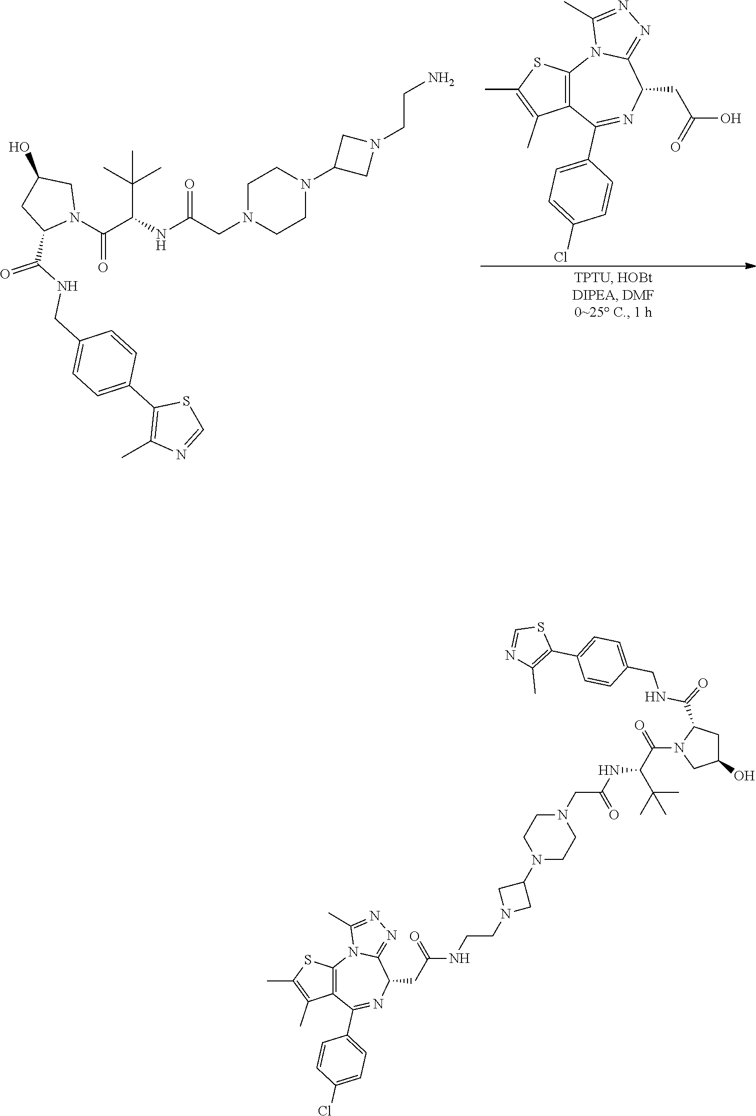 [SMILES: Cc1ncsc1-c1ccc(CNC(=O)[C@@H]2C[C@@H](O)CN2C(=O)[C@@H](NC(=O)CN2CCN(C3CN(CCN)C3)CC2)C(C)(C)C)cc1 ; Cc1sc2c(c1C)C(c1ccc(Cl)cc1)=N[C@@H](CC(=O)O)c1nnc(C)n1-2 ; Cc1ncsc1-c1ccc(CNC(=O)[C@@H]2C[C@@H](O)CN2C(=O)[C@@H](NC(=O)CN2CCN(C3CN(CCNC(=O)C[C@@H]4N=C(c5ccc(Cl)cc5)c5c(sc(C)c5C)-n5c(C)nnc54)C3)CC2)C(C)(C)C)cc1]

To a mixture of (2S,4R)-1-[(2S)-2-[[2-[4-[1-(2-aminoethyl)azetidin-3-yl]piperazin-1-yl]acetyl]amino]-3,3-dimethyl-butanoyl]-4-hydroxy-N-[[4-(4-methylthiazol-5-yl)phenyl]methyl]pyrrolidine-2-carboxamide (119.84 mg, 149.67 μmol, 4HCl salt), 2-[(9S)-7-(4-chlorophenyl)-4,5,13-trimethyl-3-thia-1,8,11,12-tetrazatricyclo[8.3.0.02,6]trideca-2(6),4,7,10,12-pentaen-9-yl]acetic acid (60 mg, 149.67 μmol) and DIPEA (116.06 mg, 898.02 μmol, 156.42 μL) in DMF (2 mL) were added HOBt (30.34 mg, 224.51 μmol) and TPTU (66.69 mg, 224.51 μmol) at 0° C. The mixture was stirred to 25° C. for 1 hour under N₂. The reaction mixture was diluted with water (2 mL) and extracted with Dichloromethane/Methanol (10/1, 3 mL×3). The combined organic phase was washed with brine (3 mL), dried with anhydrous Na₂SO₄, filtered and concentrated in vacuo. The residue was purified by preparative HPLC (column: Phenomenex luna C18 150*25 mm*10 um; mobile phase: [water (FA)-ACN]; gradient: 16%-46% B over 10 min) to afford the desired product (2S,4R)-1-[(2S)-2-[[2-[4-[1-[2-[[2-[(9S)-7-(4-chlorophenyl)-4,5,13-trimethyl-3-thia-1,8,11,12-tetrazatricyclo[8.3.0.02,6]trideca-2(6),4,7,10,12-pentaen-9-yl]acetyl]amino]ethyl]azetidin-3-yl]piperazin-1-yl]acetyl]amino]-3,3-dimethyl-butanoyl]-4-hydroxy-N-[[4-(4-methylthiazol-5-yl)phenyl]methyl]pyrrolidine-2-carboxamide (41.64 mg, 39.72 μmol, 26.54% yield, 99% purity) as a white solid. ¹H NMR: DMSO-d₆, 400 MHz. δ 8.99 (s, 1H), 8.63-8.57 (m, 1H), 8.18-8.14 (m, 2H), 7.76-7.71 (m, 1H), 7.50-7.47 (m, 2H), 7.44-7.42 (m, 2H), 7.41-7.40 (m, 3H), 5.22-5.07 (m, 1H), 4.51-4.47 (m, 2H), 4.45-4.38 (m, 2H), 4.37-4.33 (m, 2H), 4.29-4.24 (m, 1H), 3.65-3.59 (m, 4H), 3.14-3.01 (m, 8H), 2.94-2.88 (m, 2H), 2.83-2.76 (m, 4H), 2.59 (s, 3H), 2.47-2.46 (m, 2H), 2.44 (s, 3H), 2.41 (s, 3H), 2.30-2.24 (m, 2H), 2.08-2.02 (m, 1H), 1.93-1.87 (m, 1H), 1.62 (s, 3H), 0.93 (s, 9H). LCMS: RT=2.054 min, m/z 1037.6 [M+H]⁺.

### Examples C28-C56

The synthesis of Examples C-28 to C-56 have been described previously in the following literature sources Goracci, Laura, et al. “Understanding the metabolism of proteolysis targeting chimeras (PROTACs): the next step toward pharmaceutical applications.” Journal of Medicinal Chemistry 63.20 (2020): 11615-11638; Gadd, Morgan S., et al. “Structural basis of PROTAC cooperative recognition for selective protein degradation.” Nature chemical biology 13.5 (2017): 514-521; WO2018/051,107; Kounde, Cyrille S., et al. “A caged E3 ligase ligand for PROTAC-mediated protein degradation with light.” Chemical Communications 56.41 (2020): 5532-5535; WO2016/146,985; Krieger, Johannes, et al. “Systematic Potency and Property Assessment of VHL Ligands and Implications on PROTAC Design.”; Pillow, Thomas H., et al. “Antibody conjugation of a chimeric BET degrader enables in vivo activity.” ChemMedChem 15.1 (2020): 17-25; Chan, Kwok-Ho, et al. “Impact of target warhead and linkage vector on inducing protein degradation: comparison of bromodomain and extra-terminal (BET) degraders derived from triazolodiazepine (JQ1) and tetrahydroquinoline (I-BET726) BET inhibitor scaffolds.” Journal of medicinal chemistry 61.2 (2018): 504-513; and WO2021/219,077; or are close analogs (PEG linker vs. Alkyl linker; or have similar linkers (e.g., 2 linker atoms shorter/longer) to compounds described herein or in the above literature sources.

### Activity Example I: dTAG-V1 Mediated FKBP Ubiquitination by sfVHL

To assess the ability of sfVHL to act as a CUL2 adaptor protein en route to ubiquitination, sfVHL was expressed and purified recombinantly from E. coli as a complex with sfElonginB and C. The complex, sfVHL; sfElonginB/C, was combined with human CUL2/RBX1 (R&D systems E3-420-025, human E1 (UBE1, R&D Systems E-304-050), human E2 (UBcH5a, R&D Systems E2-616-100), ATP, MgCl₂, ubiquitin, dTAGV-1 at a range of concentrations, and protein of interest MBP-FKBP-Hibit-His6 which was recombinantly purified from E. coli. After incubation at room temperature, Western blot analysis was performed with an anti-His6 antibody (Invitrogen PA1-983B). In the presence of dTAGV-1 a multimeric band pattern above the signal for unmodified MBP-FKBP-Hibit-His6 was observed indicating PROTAC mediated mono- and poly-ubiquitination of the protein. The intensity and number of resolved bands observed, each indicating a distinct ubiquitination pattern of MBP-FKBP-Hibit-His6, was dependent on the dTAGV-1 concentration in the preparation. No signal for ubiquitinated MBP-FKBP-Hibit-His6 was observed in the control experiment lacking dTAGV-1. Further, ubiquitination as indicated by the complex band pattern above the MBP-FKBP-Hibit-His6 protein, was only observed when sfVHL:sfElonginB/C+CUL2/RBX1 was present confirming that the observed ubiquitination is PROTAC and sfVHL:sfElonginB/D+CUL2/RBX1 complex dependent. These results suggest that sfVHL successfully acts as an E3 adaptor protein that can be leveraged for PROTAC dependent ubiquitination.

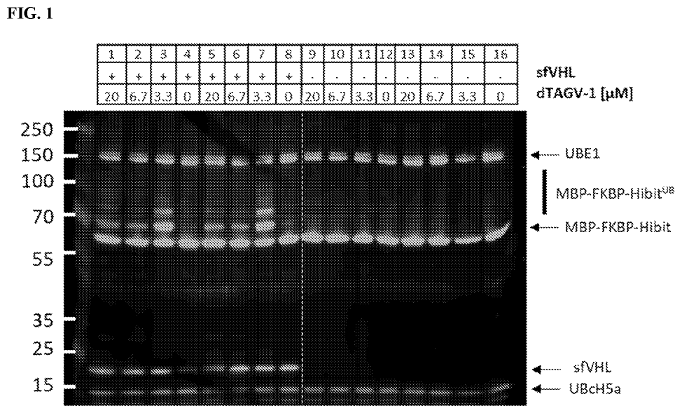

To assess the ability of sfVHL to act as a CUL2 adaptor protein en route to ubiquitination, sfVHL was expressed and purified recombinantly from E. coli as a complex with sfElonginB and C. The complex, sfVHL; sfElonginB/C, was combined with human CUL2/RBX1 (R&D systems E3-420-025, human E1 (UBE1, R&D Systems E-304-050), human E2 (UBcH5a, R&D Systems E2-616-100), ATP, MgCl₂, ubiquitin, dTAGV-1 at a range of concentrations, and protein of interest MBP-FKBP-Hibit-His6 which was recombinantly purified from E. coli. After incubation at room temperature, Western blot analysis was performed with an anti-His6 antibody (Invitrogen PA1-983B). Ubiquitination of MBP-FKBP-Hibit-His6 was observed in the presence of dTAGV-1 in a dose dependent manner (FIG. 1, Lanes 1-4 & 5-8), while absent in the control lacking dTAGV-1 (FIG. 1, Lanes 9-16). Further, ubiquitination was only observed when sfVHL:sfElonginB/C+CUL2/RBX1 was present confirming that MBP-FKBP-Hibit-His6 ubiquitination is PROTAC and sfVHL:sfElonginB/D+CUL2/RBX1 complex dependent. These results suggest that sfVHL successfully acts as an E3 adaptor protein that can be leveraged for PROTAC dependent ubiquitination.

### Activity Example II: sfVHL Mediated FKBP Degradation with dTAG Tool Compounds

Sf9 cells were seeded into individual wells of 6-well sterile tissue culture plates (2×106 cells per well) with 2 mL fresh Sf900 III serum-free medium prior to the assay. The Sf9 cells were transfected with a plasmid expressing FKBP-GFP-P2A-RFP. Plasmid construct (in TE buffer) was aliquoted into a sterile Eppendorf microcentrifuge tube, with fresh sSf900 III medium added to each Plasmid. Cellfectin II reagent (Life Technologies, Carlsbad, CA) was then added to the transfection mixture, and the tubes were inverted to mix and incubated at room temperature for 30 minutes. All media was removed from each well just prior to the addition of the transfection mixture. Complete transfection mixtures were added to cells dropwise using a P1000 pipette with sterile filter tips. Cells overlayed with transfection mixtures were incubated at 27° C. for 4 hours. Following 4 hours of incubation time, transfection mixtures were removed and replaced with 2 mL of fresh complete medium per well (Sf900 III). Cells were allowed to incubate at 27° C. for 96 hours to allow expression from the transfected plasmid. After construct expression, cells are harvested for further experiments. Cells were detached using a P1000 pipette with sterile filter tips. Cells were resuspended in fresh Sf900 III medium. Transfected Sf9 cells were seeded into individual wells of 96-well sterile tissue culture plates (1×10⁶ cells per well) with 0.1 mL fresh Sf900 III serum-free medium. Cells were then supplemented with a 10× stock of the indicated compounds (dTAGV1, dTAG-V1-NEG, Bortezomib). Protein levels were finally analyzed using Carl Zeiss microscopy and FIJI image analysis.

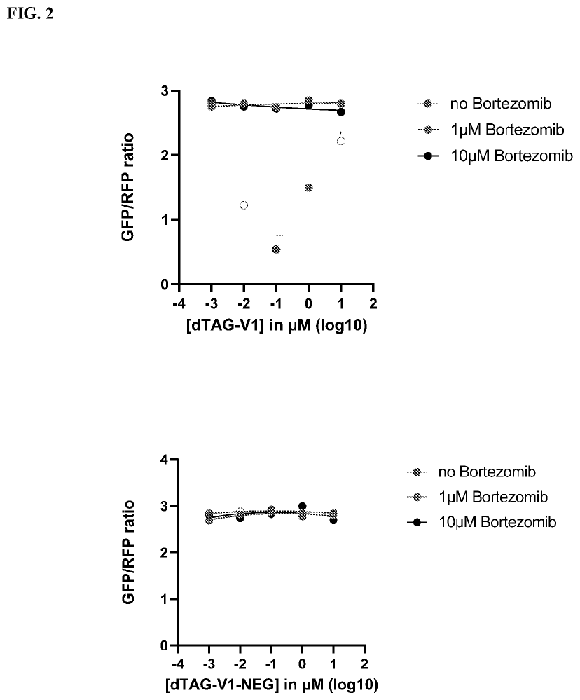

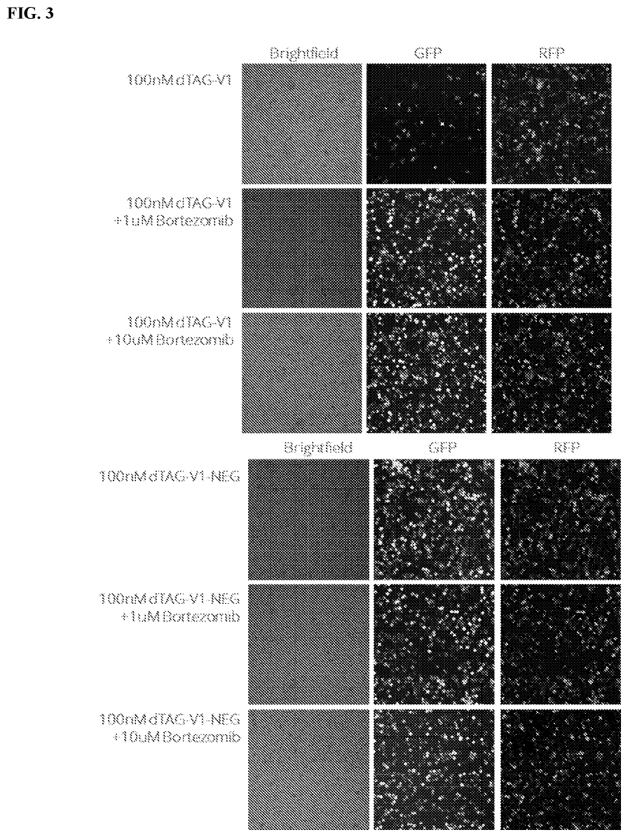

When dTAG-V1 is added to Sf9 cells expressing FKBP-GFP-P2A-RFP, GFP fluorescence significantly decreased after 24 hours of incubation, optimally at ˜100 nM concentration, while RFP signal remains unchanged. The addition of bortezomib, a well characterized proteasome inhibitor, prevents the dTAG-V1 dependent reduction of GFP signal. See FIGS. 2-3. When negative control (dTAG-V1-NEG) is added, no decrease in green fluorescent protein is observed. See FIGS. 2-3. These results indicate the Sf9 VHL is able to bind to dTAG-V1 PROTAC and induced UPS-dependent degradation of FKBP-GFP.

### Activity Example III: sfVHL Mediated WDS and BRD3 Degradation with PROTACS

A number of BRD3 and WDS targeting PROTACs, as described above, were tested for their ability to degrade target proteins in insect cells according to the following general experimental procedure. About 10⁶ Sf9 cells were seeded into individual wells of 96-well sterile deep well plates with 0.45 mL fresh Sf900 III serum-free medium prior to the assay. The medium in each well was supplemented with a 10× stock of the indicated PROTAC compounds to achieve the final desired concentration for that well, and the plates were then incubated for 24 hours. Cells were harvested for protein analysis and lysed. Cell lysates were digested with trypsin/LysC at 37° C. overnight, followed by tryptic peptide extraction using an OASIS MCX plate, and then dried (vacuum) for storage. The extracted lysates were solubilized and injected on a liquid chromatography-tandem mass spectrometer (LC-MS/MS) set to monitor fragment ion transitions corresponding to proteotypic peptides for each target protein. The resulting MS/MS spectra from each LC-MS/MS run were analyzed using Skyline data analysis software to investigate PROTAC compound-dependent changes to the target protein.

D_{Max} values indicating degradation efficiencies were determined for each of the tested compounds as summarized in Table 4.

TABLE 4

| D_{Max} | Tested Compounds |
|---|---|
| D_{Max} ≥75% | C-12, C-31, C-32, C-33, C-35, C-42, C-43, C-47, C-48, |
| | C-52, C-53, and C-56 |
| D_{Max} 50-<75% | B-5, B-13, B-18, B-19, B-31, B-32, C-29, and C-30 |
| D_{Max} <50% | B-4, B-6, B-7, B-8, B-14, B-15, B-17, B-26, B-27, B-28, |
| | B-29, B-43, B-68, B-77, B-80, C-28, C-37, C-38, and |
| | C-40 |
| D_{Max} No | B-1, B-2, B-3, B-10, B-11, B-12, B-23, B-24, B-25, |
| Degradation | B-44, B-45, B-48, B-69, B-70, B-71, B-72, B-73, B-74, |
| Observed | B-75, B-76, B-78, B-79, B-81, B-82, B-83, B-84, B-85, |
| | B-86, B-90, and C-54 |

All technical and scientific terms used herein, unless otherwise defined below, are intended to have the same meaning as commonly understood by one of ordinary skill in the art.

References to techniques employed herein are intended to refer to the techniques as commonly understood in the art, including variations on those techniques and/or substitutions of equivalent techniques that would be apparent to one of skill in the art.

All patents, patent publications, patent applications, journal articles, books, technical references, and the like discussed in the instant disclosure are incorporated herein by reference in their entirety for all purposes.

In the foregoing description, numerous specific details are set forth to provide a more thorough understanding of the present disclosure. However, it will be apparent to one of skill in the art that the embodiments described in this disclosure may be practiced without one or more of these specific details. In other instances, well-known features and procedures well known to those skilled in the art have not been described in order to avoid obscuring the disclosure. Embodiments of the disclosure have been described for illustrative and not restrictive purposes. Although the present disclosure is described primarily with reference to specific embodiments, it is also envisioned that other embodiments will become apparent to those skilled in the art upon reading the present disclosure, and it is intended that such embodiments be contained within the present inventive methods. Accordingly, the present disclosure is not limited to the embodiments described above or depicted in the drawings, and various embodiments and modifications can be made without departing from the scope of the claims below.

1. A method of controlling a level of a target protein that is expressed in an insect cell, the method comprising contacting the insect cell with an effective amount of a compound, the compound comprising:
one or more protein targeting moieties (PTM) that each independently bind the target protein;
one or more ligase targeting moieties (LTM) that each independently bind a ubiquitin ligase that is functional in the insect cell; and
a linker (L) covalently bonded to the one or more protein targeting moieties and the one or more ligase targeting moieties.

2. The method of claim 1, wherein the ubiquitin ligases that the one or more ligase targeting moieties bind to comprise the von Hippel-Lindau tumor suppressor (VHL) or cereblon.

3. The method of claim 2, wherein at least one of the one or more ligase targeting moieties has a structure according to the formula: 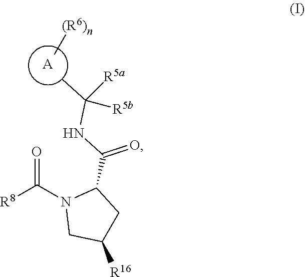
wherein
R^{5a} and R^{5b} are each independently hydrogen, hydroxyl, amine, haloalkyl, optionally substituted alkyl, optionally substituted alkoxy, optionally substituted hydroxyl alkyl, optionally substituted alkylamine, optionally substituted amide, optionally substituted alkyl-amide, optionally substituted alkyl-cyano, optionally substituted alkyl-phosphate, optionally substituted aryl, optionally substituted alkyl-aryl, optionally substituted heteroalkyl, optionally substituted alkyl-heterocyclyl, optionally substituted alkoxy-heterocyclyl, COR¹⁴, alkyl-COR¹⁴, CONR^{15a}R^{15b}, NHCOR¹⁴, NHCH₃COR¹⁴, or —X-L¹, or are combined with the carbon atom to which they are attached to form an optionally substituted 3- to 5-membered cycloalkyl, heterocyclyl, spirocycloalkyl, or spiroheterocyclyl, wherein the spiroheterocyclyl is not epoxide or aziridine;
each R⁶ is independently C₁₋₆ alkyl, halogen, C₁₋₆ haloalkyl, hydroxy, C₁₋₆ alkoxy, C₁₋₆ haloalkoxy, C₃₋₈ cycloalkyl, C₆₋₁₂ aryl, C₅₋₁₂ heteroaryl, C₃₋₁₅ heterocyclyl, cyano, nitro, NR^{15a}R^{15b}, OR¹⁴, CONR^{15a}R^{15b}, NR^{15a}COR^{15b}, SO₂NR^{15a}R^{15b}, NR^{15a}SO₂R^{15b}, or —X-L¹, wherein the alkyl, haloalkyl, alkoxy, cycloalkyl, aryl, heteroaryl, and heterocyclyl are optionally substituted with 1 to 4 R^{6a} groups;
R⁸ is an optionally substituted aryl, optionally substituted heteroaryl, or 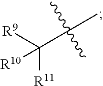
R⁹ and R¹⁰ are independently hydrogen, optionally substituted alkyl, optionally substituted cycloalkyl, optionally substituted hydroxyalkyl, optionally substituted heteroaryl, haloalkyl, or 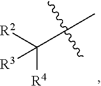
or are combined with the carbon atom to which they are attached to form an optionally substituted cycloalkyl;
R² and R³ are each independently hydrogen, C₁₋₆ alkyl, or C₁₋₆ hydroxyalkyl, or are combined with the carbon to which they are attached to form a C₃₋₈ cycloalkyl, C₆₋₁₂ aryl, or C₅₋₁₂ heteroaryl, wherein the cycloalkyl, aryl and heteroaryl are optionally substituted with 1 to 4 R^{2a} groups;
R⁴ is hydrogen, C₁₋₆ alkyl, C₁₋₆ hydroxyalkyl, or —X-L¹;
R₁₁ is an optionally substituted heterocyclyl, optionally substituted alkoxy, optionally substituted heteroaryl, optionally substituted aryl, 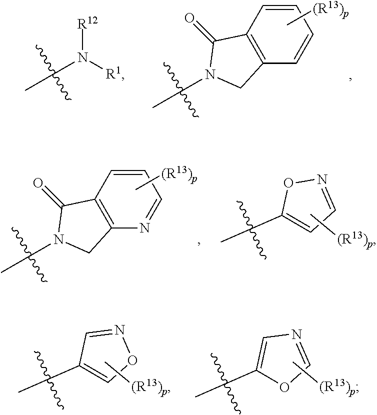
R¹ is hydrogen, optionally substituted alkyl, optionally substituted alkylcarbonyl, optionally substituted (cycloalkyl)alkylcarbonyl, optionally substituted aralkylcarbonyl, optionally substituted arylcarbonyl, optionally substituted (heterocyclyl)carbonyl, optionally substituted aralkyl, —C(O)R^{1a}, or —C(O)—X-L¹;
R^{1a} is C₁₋₆ alkyl, C₃₋₈ cycloalkyl, C₆₋₁₂ aryl, or C₅₋₁₂ heteroaryl, wherein the cycloalkyl, aryl, and heteroaryl are optionally substituted with 1 to 4 R^{1b} groups;
each R^{1b}, R^{2a}, and R^{6a} is independently C₁₋₆ alkyl, cyano, halogen, C₁₋₆ haloalkyl, hydroxy, C₁₋₆ alkoxy, C₁₋₆ haloalkoxy, or —X-L¹;
R¹² is hydrogen or optionally substituted alkyl;
each R¹³ is independently hydrogen, halogen, optionally substituted alkoxy, cyano, optionally substituted alkyl, haloalkyl, haloalkoxy, or —X-L¹;
each R¹⁴ is independently hydrogen, OH, O—C₁₋₆ alkyl, optionally substituted alkyl, or NR^{15a}R^{15b};
R^{15a} and R^{15b} are each independently hydrogen, optionally substituted alkyl, or optionally substituted cycloalkyl, or are combined with the nitrogen atom to which they are attached to form a 4- to 6-membered heterocyclyl;
R¹⁶ is hydroxy, a group that can be metabolized to hydroxy, or sulfonyl halide;
A is optionally substituted phenyl, optionally substituted napthyl, or an optionally substituted 5- to 10-membered heteroaryl;
X is a bond, CH₂, NH, NMe, O, or S;
L¹ is a site of attachment to the linker; and
the subscripts n and p are each independently an integer from 0 to 4.

4. The method of claim 3, wherein at least one of the one or more ligase targeting moieties has a structure according to the formula: 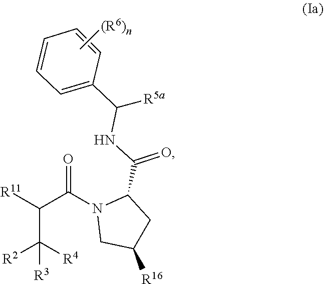
wherein
R¹ is hydrogen, C₁₋₆ alkyl, —C(O)R^{1a}, or —C(O)—X-L¹;
R⁴ is hydrogen, C₁₋₆ alkyl, C₁₋₆ hydroxyalkyl, or —X-L¹;
R^{5a} is hydrogen, C₁₋₆ alkyl, halogen, C₁₋₆ haloalkyl, C₁₋₆ alkyl-amide, hydroxy, C₁₋₆ alkoxy, C₁₋₆ haloalkoxy or —X-L¹; and
each R⁶ is independently C₁₋₆ alkyl, halogen, C₁₋₆ haloalkyl, hydroxy, C₁₋₆ alkoxy, C₁₋₆ haloalkoxy, C₃₋₈ cycloalkyl, C₆₋₁₂ aryl, C₅₋₁₂ heteroaryl, OR¹⁴, or —X-L¹, wherein the cycloalkyl, aryl, and heteroaryl are optionally substituted with 1 to 4 R^{6a} groups.

5. The method of claim 3, wherein
R¹ is —C(O)R^{1a} or —C(O)—X-L¹; and
R^{1a} is C₁₋₆ alkyl or C₃₋₈ cycloalkyl, wherein the cycloalkyl is optionally substituted with 1 to 4 R^{1b} groups.

6. The method of claim 3 wherein R² and R³ are each independently C₁₋₆ alkyl.

7. The method of claim 3, wherein R⁴ is C₁₋₆ alkyl or —X-L¹.

8. The method of claim 3, wherein R^{5a} is hydroxy or methyl.

9. The method of claim 3, wherein
each R⁶ is independently C₅₋₁₂ heteroaryl or —X-L¹, wherein the heteroaryl is optionally substituted with 1 to 4 R^{6a} groups; and
each R^{6a} is independently C₁₋₆ alkyl.

10. The method of claim 9, wherein each R⁶ is independently thiazole or —X-L¹, wherein the thiazole is optionally substituted with 1 to 4 R^{6a} groups.

11. The method of claim 3, wherein subscript n is 1 or 2.

12. The method of claim 3, wherein at least one of the one or more ligase targeting moieties has a structure according to the formula:

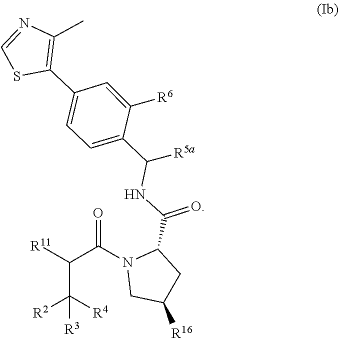

13. The method of claim 12, wherein at least one of the one or more ligase targeting moieties has the structure:

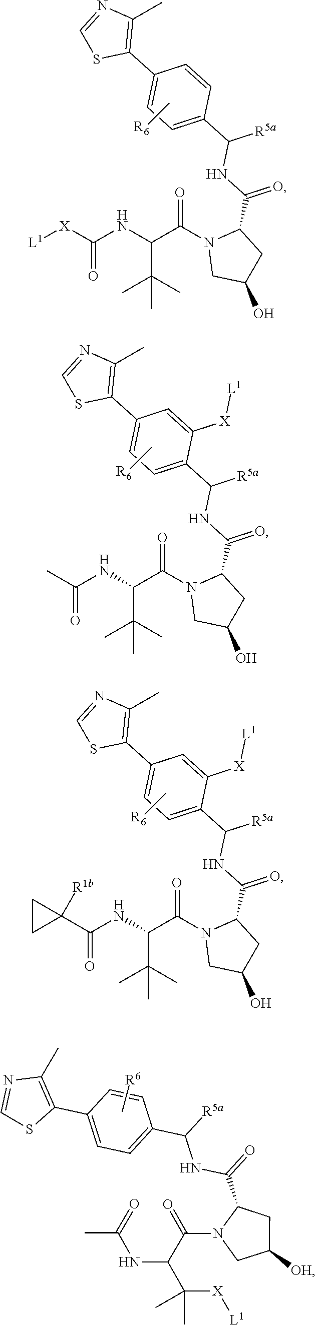

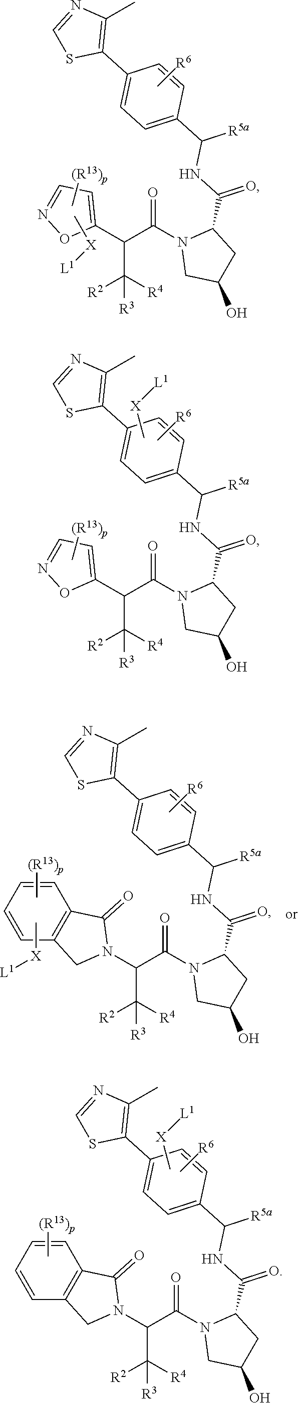

14. The method of claim 2, wherein at least one of the one or more ligase targeting moieties comprises an N-substituted 1,3,-dioxoisoindolinyl moiety optionally substituted with one or more substituents that are each independently C₁₋₆ alkyl, halogen, hydroxy, amino, C₁₋₆ alkylamino, C₁₋₆ amido, C₁₋₆ acyl, nitro, cyano, or C₁₋₆ alkoxy.

15. The method of claim 1, wherein the linker has a linear non-hydrogen atom number from 1 to 20.

16. The method of claim 1, wherein the linker has a structure -L²-L³-, wherein
L² and L³ are each independently a bond, a divalent polymer moiety, or C₁₋₃₀ alkylene, wherein
one or more carbon atoms in each C₁₋₃₀ alkylene are optionally and independently replaced by O, C(O), S, or NR⁷;
one or more groupings of adjacent carbon atoms in each C₁₋₃₀ alkylene are optionally and independently replaced by —NR⁷(CO)— or —(CO)NR⁷—; and
one or more groupings of adjacent carbon atoms in each C₁₋₃₀ alkylene are optionally and independently replaced by a 4- to 8-membered, divalent carbocycle or a 4- to 8-membered, divalent heterocycle having one to four heteroatoms selected from O, S, and N; and
each R⁷ is independently hydrogen or C₁₋₆ alkyl.

17. The method of claim 1, wherein the linker comprises one or more ethylene glycol diradical moieties, one or more of which is optionally replaced by the moiety:

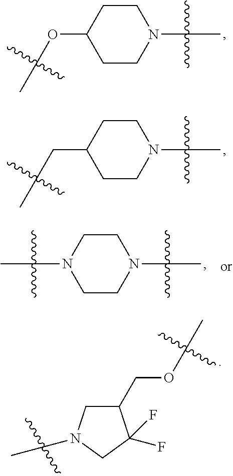 [SMILES: *OC1CCN(*)CC1 ; *CC1CCN(*)CC1 ; *N1CCN(*)CC1 ; *OCC1CN(*)CC1(F)F]

18. The method of claim 1, wherein at least one of the one or more protein targeting moieties has the structure: 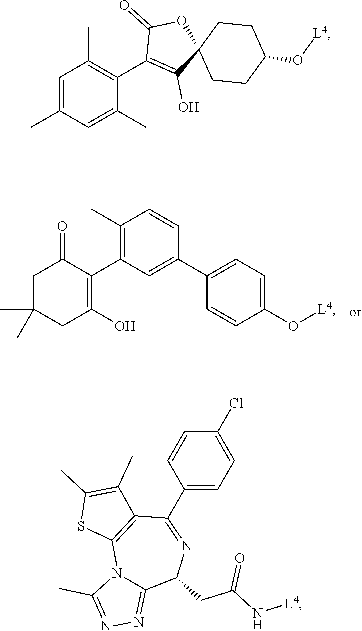
wherein L⁴ is a site of attachment to the linker.

19. The method of claim 1, wherein the proteins that the one or more protein targeting moieties bind to are essential to growth, development, reproduction, or survival of the insect.

20. The method of claim 19, wherein the proteins comprise acetyl CoA carboxylase, acetylcholinesterase, GABA-gated chloride channels, sodium channels, nicotinic acetylcholine receptors, glutamate-gated chloride channels, chordontal organ TRPV channels, chitin synthase, mitochondrial ATP synthase, ecdysone receptors, octopamine receptors, voltage-dependent sodium channels, ryanodine receptors, calcium-activated potassium channels, juvenile hormone receptors, Bromaindomain Containing 3 (BRD3), chitin acetyltransferase, Cholone O-Acetyltransferase (ChAT), Dihydrofolate Reductase (DHFR), FK506 binding proteins (FKBP), Geranylgeranyl diphosphate synthase 1 (GGPS1), 3-Hydroxy-3Methylglutaryl-CoA Reductase (HMGCR), Inosine-5′-monophosphate dehydrogenase (IMPDH), Juvenile hormone acid O-methyltranserase (JHAMT), lysine-tRNA ligase (KRS1), MET Proto-Oncogene, Receptor Tyrosine Kinase (MET), Thioredoxin reductase (TXNRD), N-myristoyl transferase (NMT), SWI/SNF Related, Matrix Associated, Actin Dependent Regulator of Chromatin, Subfamily A, Member 2 (SMARCA2), USP and Will Die Slowly (WDS) or a combination thereof.

21. The method of claim 20, wherein the proteins comprise Bromaindomain Containing 3 (BRD3) or Will Die Slowly (WDS).

22. The method of claim 1, wherein the insect cell is a cell of an insect that is a member of the order Lepidoptera, Coleoptera, Diptera, Hymenoptera, Mallophaga, Homoptera, Hemiptera, Orthoptera, Thysanoptera, Dermaptera, Isoptera, Anoplura, Siphonaptera, or Trichoptera.

23. The method of claim 22, wherein the insect is a member of the order Lepidoptera.

24. A composition comprising the compound of claim 1, or a salt or solvate thereof, and an agriculturally acceptable carrier.

25. A method of controlling a level of a target protein in an insect cell, the method comprising contacting the insect cell with an effective amount of the compound of claim 1.

26. The method of claim 25, wherein the controlling of the level of the target protein comprises degrading the target protein.

27. The method of claim 25, wherein the insect cell is a cell of an insect, and wherein the contacting of the insect cell with an effective amount of the compound or composition comprises applying the compound or composition to an environment in which the insect is present.

28. The method of claim 27, wherein the compound or composition is applied to an insect pest, a plant, a seed, the soil, or other surface in the environment in which the insect is present.
